(19) United States
(12) Patent Application Publication
(10) Pub. No.: US 2007/0080905 A1
(43) Pub. Date: Apr. 12, 2007

(54) El display and its driving method

(75) Inventor: Hiroshi Takahara, Osaka (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Toshiba Matsushita Display Technology Co., Ltd., Tokyo (JP)

(21) Appl. No.: 10/555,460

(22) PCT Filed: Apr. 28, 2004
(86) PCT No.: PCT/JP04/06153

§ 371 Date: Nov. 4, 2005

(30) Foreign Application Priority Data
May 7, 2003 (JP) 2003-129528
Jul. 18, 2003 (JP) 2003-277166
Feb. 20, 2004 (JP) 2004-045517

(51) Int. Cl. G09G 3/30

(52) U.S. Cl. 345/76

(57) ABSTRACT

It is difficult to obtain a good image display by using an organic EL display panel.

An EL display apparatus includes EL elements 15 and driving transistors 11a placed like a matrix, a voltage gradation circuit 1271 for generating a program voltage signal, a current gradation circuit 164 for generating a program current signal, and a drive circuit means of applying a signal to the driving transistors 11a, having switches 151a and 151b for switching between the program voltage signal and the program current signal.

### TECHNICAL FIELD

The present invention relates to a self-luminous display panel such as an EL display panel (display apparatus) which employs organic or inorganic electroluminescent (EL) elements and the like. Also, it relates to such as a drive circuit (IC etc.) and a drive method for the display panel and the like.

### BACKGROUND ART

With active-matrix display apparatus which employ an organic electroluminescent (EL) material as an electrochemical substance, emission brightness changes according to current written into pixels. An organic EL display panel is of a self-luminous type in which each pixel has a light-emitting element. Organic EL display panels have the advantages of being more viewable than liquid crystal display panels, requiring no backlighting, having high response speed, etc.

A construction of organic EL display panels can be either a simple-matrix type or active-matrix type. It is difficult to implement a large high-resolution display panel of the former type although the former type is simple in structure and inexpensive. The latter type allows a large high-resolution display panel to be implemented. However, the latter type involves a problem that it is a technically difficult control method and is relatively expensive. Currently, active-matrix type display panels are developed intensively. In the active-matrix type display panel, current flowing through the light-emitting elements provided in each pixel is controlled by thin-film transistors (transistors) installed in the pixels.

An organic EL display panel of an active-matrix type is disclosed in, for example, Japanese Patent Laid-Open No. 8-234683.

The disclosure of the above reference is incorporated herein by reference in its entirety.

An equivalent circuit for one pixel of the display panel is shown in FIG. 2. A pixel 16 consists of an EL element 15 which is a light-emitting element, a first transistor (driver transistor) 11a, a second transistor (switching transistor) 11b, and a storage capacitance (condenser) 19. The light-emitting element 15 is an organic electroluminescent (EL) element. The transistor 11a which supplies (controls) current to the EL element 15 is herein referred to as a driver transistor 11. A transistor, such as the transistor 11b shown in FIG. 2, which operates as a switch, is referred to as a switching transistor 11.

The organic EL element 15, in many cases, may be referred to as an OLED (organic light-emitting diode) because of its rectification. In FIG. 1, 2 or the like, a diode symbol is used for the light-emitting element 15.

The light-emitting element 15 according to the present invention is not limited to an OLED. It may be of any type as long as its brightness is controlled by the amount of current flowing through the element 15. Examples include an inorganic EL element, a white light-emitting diode consisting of a semiconductor, and a light-emitting transistor. Rectification is not necessarily required of the light-emitting element 15. Bi directional elements are also available.

Drive in FIG. 2 is explained below. A video signal of voltage which represents brightness information is first applied to the source signal line 18 with the gate signal line 17 selected. The transistor 11a conducts and the video signal is charged to the storage capacitance 19. When the gate signal line 17 is des elected, the transistor 11a is turned off. The transistor 11b is cut off electrically from the source signal line 18. However, the gate terminal potential of the transistor 11a is maintained stably by the storage capacitance (capacitor) 19. Current delivered to the luminance element 15 via the transistor 11a depends on gate-drain voltage Vgd of the transistor 11a. The luminance element 15 continues to emit light at an intensity which corresponds to the amount of current supplied via the transistor 11a.

Organic EL display panels are made of low-temperature poly-silicon transistor arrays. However, since organic EL elements use current to emit light, variations in the transistor characteristics of the poly-silicon transistor arrays cause display irregularities.

FIG. 2 shows pixel configuration for voltage programming mode. With the pixel configuration shown in FIG. 2 the voltage-based video signal is converted into a current signal by the transistor 11a. Thus, any variation in the characteristics of the transistor 11a causes variations in the resulting current signal. Generally, the transistor 11a has 50% or more variations in its characteristics. Consequently, the configuration in FIG. 2 causes display irregularities.

The display irregularities which are generated by current programming can be reduced using current programming. For current programming, a current-driven driver circuit is required. However, with a current-driven driver circuit, variations will also occur in transistor elements which compose a current output stage. This in turn causes variations in gradation output currents from output terminals, making it impossible to display images properly. In the voltage programming mode, the drive current is small in a low gradation region. Thus, parasitic capacitance of the source signal line 18 can prevent proper driving. In particular, the current for the 0-th gradation is zero. This sometimes makes it impossible to change image display.

In this way, it is difficult to obtain proper display using an organic EL display panel.

### DISCLOSURE OF THE INVENTION

The 1^{st} aspect of the present invention is an EL display apparatus comprising:

EL elements and drive elements placed like a matrix;

a voltage gradation circuit for generating a program voltage signal;

current circuit means of generating a program current signal; and

a drive circuit means of applying a signal to the drive elements, having a switching circuit for switching between the program voltage signal and the program current signal.

The 2^{nd} aspect of the present invention is a driving method of an EL display apparatus having EL elements and drive elements placed like a matrix formed therein and having a source signal line for stamping a signal to the drive elements, in which:

one horizontal scanning period has a period A for applying a voltage signal to the source signal line and a period B for applying a current signal to the source signal line; and

the period B is started after an end of, or concurrently with the period A.

The 3^{rd} aspect of the present invention is an EL display apparatus comprising:

a first source driver circuit connected to one end of a source signal line; and

a second source driver circuit connected to the other end of the source signal line,

in which the first source driver circuit and the second source driver circuit output currents corresponding to gradations.

The 4^{th} aspect of the present invention is a driving method of an EL display apparatus having pixels formed like a matrix, in which:

a lighting rate is acquired from a size of a video signal applied to the EL display apparatus so as to control a flowing current correspondingly to the lighting rate.

The 5^{th} aspect of the present invention is an EL display apparatus comprising:

a first reference current source for prescribing a size of a first output current to be applied to red pixels;

a second reference current source for prescribing a size of a second output current to be applied to green pixels;

a third reference current source for prescribing a size of a third output current to be applied to blue pixels; and

control means of controlling the first reference current source, the second reference current source and the third reference current source,

in which the control means changes the sizes of the first output current, the second output current and the third output current in proportion.

In this way, the driver circuit of the display panel (display apparatus) according to the present invention comprises a plurality of transistors which output unit currents, and produces an output current by varying the number of transistors. Also, the display apparatus and the like according to the present invention perform duty ratio control, reference current control, etc.

The source driver circuit according to the present invention has a reference current generator circuit and performs current control and brightness control by controlling the gate driver circuit. The pixel has one or more driver transistors, which are driven in such a way as to prevent variations in the current flowing through the EL element 15. This makes it possible to reduce display irregularities caused by variations in the thresholds of the transistors. Also, duty ratio control and the like make it possible to achieve an image display with a wide dynamic range.

The display panel, display apparatus, etc. according to the present invention provide peculiar advantages, including high image quality, proper movie display, low power consumption, low costs, and high brightness, depending on their configuration.

Since the present invention can reduce power consumption of information display apparatus and the like, it can save power. Also, since it can reduce the size and weight of information display apparatus and the like, it does not waste resources. Thus, the present invention is familiar to the global environment and space environment.

### BRIEF DESCRIPTION OF THE DRAWINGS

FIG. 1 is a block diagram of a display panel according to the present invention;

FIG. 2 is a block diagram of a display panel according to the present invention;

FIG. 3 is an explanatory diagram of a display panel according to the present invention;

FIG. 4 is an explanatory diagram of a display panel according to the present invention;

FIG. 5 is an explanatory diagram illustrating a drive method of a display apparatus according to the present invention;

FIG. 6 is an explanatory diagram of a display panel according to the present invention;

FIG. 7 is an explanatory diagram of a display panel according to the present invention;

FIG. 8 is an explanatory diagram of a display panel according to the present invention;

FIG. 9 is an explanatory diagram of a display panel according to the present invention;

FIG. 10 is an explanatory diagram of a display panel according to the present invention;

FIG. 11 is an explanatory diagram of a display panel according to the present invention;

FIG. 12 is an explanatory diagram of a display panel according to the present invention;

FIG. 13 is an explanatory diagram of a display panel according to the present invention;

FIG. 14 is an explanatory diagram of a display panel according to the present invention;

FIG. 15 is an explanatory diagram of a display panel according to the present invention;

FIG. 16 is an explanatory diagram of a display panel according to the present invention;

FIG. 17 is an explanatory diagram of a display panel according to the present invention;

FIG. 18 is an explanatory diagram of a display panel according to the present invention;

FIG. 19 is an explanatory diagram illustrating a drive method of a display panel according to the present invention;

FIG. 20 is an explanatory diagram illustrating a drive method of a display panel according to the present invention;

FIG. 21 is an explanatory diagram illustrating a drive method of a display panel according to the present invention;

FIG. 22 is an explanatory diagram of a display panel according to the present invention;

FIG. 23 is an explanatory diagram illustrating a drive method of a display panel according to the present invention;

FIG. 24 is an explanatory diagram illustrating a drive method of a display panel according to the present invention;

FIG. 25 is an explanatory diagram illustrating a drive method of a display panel according to the present invention;

FIG. 26 is an explanatory diagram illustrating a drive method of a display panel according to the present invention;

FIG. 27 is an explanatory diagram illustrating a drive method of a display panel according to the present invention;

FIG. 28 is an explanatory diagram of a display panel according to the present invention;

FIG. 29 is an explanatory diagram of a source driver circuit (IC) according to the present invention;

FIG. 30 is an explanatory diagram of a source driver circuit (IC) according to the present invention;

FIG. 31 is an explanatory diagram of a display panel according to the present invention;

FIG. 32 is an explanatory diagram of a display panel according to the present invention;

FIG. 33 is an explanatory diagram of a display panel according to the present invention;

FIG. 34 is an explanatory diagram of a display panel according to the present invention;

FIG. 35 is an explanatory diagram of a display panel according to the present invention;

FIG. 36 is an explanatory diagram of a display panel according to the present invention;

FIG. 37 is an explanatory diagram illustrating a drive method of a display panel according to the present invention;

FIG. 38 is an explanatory diagram illustrating a drive method of a display panel according to the present invention;

FIG. 39 is an explanatory diagram illustrating a drive method of a display panel according to the present invention;

FIG. 40 is an explanatory diagram illustrating a drive method of a display panel according to the present invention;

FIG. 41 is an explanatory diagram illustrating a drive method of a display panel according to the present invention;

FIG. 42 is an explanatory diagram illustrating a drive method of a display panel according to the present invention;

FIG. 43 is an explanatory diagram of a source driver circuit (IC) according to the present invention;

FIG. 44 is an explanatory diagram of a source driver circuit (IC) according to the present invention;

FIG. 45 is an explanatory diagram of a source driver circuit (IC) according to the present invention;

FIG. 46 is an explanatory diagram of a source driver circuit (IC) according to the present invention;

FIG. 47 is an explanatory diagram of a source driver circuit (IC) according to the present invention;

FIG. 48 is an explanatory diagram of a source driver circuit (IC) according to the present invention;

FIG. 49 is an explanatory diagram of a source driver circuit (IC) according to the present invention;

FIG. 50 is an explanatory diagram of a source driver circuit (IC) according to the present invention;

FIG. 51 is an explanatory diagram of a source driver circuit (IC) according to the present invention;

FIG. 52 is an explanatory diagram of a source driver circuit (IC) according to the present invention;

FIG. 53 is an explanatory diagram of a source driver circuit (IC) according to the present invention;

FIG. 54 is an explanatory diagram of a source driver circuit (IC) according to the present invention;

FIG. 55 is an explanatory diagram of a source driver circuit (IC) according to the present invention;

FIG. 56 is an explanatory diagram of a source driver circuit (IC) according to the present invention;

FIG. 57 is an explanatory diagram of a source driver circuit (IC) according to the present invention;

FIG. 58 is an explanatory diagram of a source driver circuit (IC) according to the present invention;

FIG. 59 is an explanatory diagram of a source driver circuit (IC) according to the present invention;

FIG. 60 is an explanatory diagram of a source driver circuit (IC) according to the present invention;

FIG. 61 is an explanatory diagram of a source driver circuit (IC) according to the present invention;

FIG. 62 is an explanatory diagram of a source driver circuit (IC) according to the present invention;

FIG. 63 is an explanatory diagram of a source driver circuit (IC) according to the present invention;

FIG. 64 is an explanatory diagram of a source driver circuit (IC) according to the present invention;

FIG. 65 is an explanatory diagram of a source driver circuit (IC) according to the present invention;

FIG. 66 is an explanatory diagram of a source driver circuit (IC) according to the present invention;

FIG. 67 is an explanatory diagram of a source driver circuit (IC) according to the present invention;

FIG. 68 is an explanatory diagram of a source driver circuit (IC) according to the present invention;

FIG. 69 is an explanatory diagram of a source driver circuit (IC) according to the present invention;

FIG. 70 is an explanatory diagram of a source driver circuit (IC) according to the present invention;

FIG. 71 is an explanatory diagram of a source driver circuit (IC) according to the present invention;

FIG. 72 is an explanatory diagram of a source driver circuit (IC) according to the present invention;

FIG. 73 is an explanatory diagram of a source driver circuit (IC) according to the present invention;

FIG. 74 is an explanatory diagram of a source driver circuit (IC) according to the present invention;

FIG. 75 is an explanatory diagram of a source driver circuit (IC) according to the present invention;

FIG. 76 is an explanatory diagram of a source driver circuit (IC) according to the present invention;

FIG. 77 is an explanatory diagram of a source driver circuit (IC) according to the present invention;

FIG. 78 is an explanatory diagram of a source driver circuit (IC) according to the present invention;

FIG. 79 is an explanatory diagram of a source driver circuit (IC) according to the present invention;

FIG. 80 is an explanatory diagram of a source driver circuit (IC) according to the present invention;

FIG. 81 is an explanatory diagram of a source driver circuit (IC) according to the present invention;

FIG. 82 is an explanatory diagram of a source driver circuit (IC) according to the present invention;

FIG. 83 is an explanatory diagram of a source driver circuit (IC) according to the present invention;

FIG. 84 is an explanatory diagram of a source driver circuit (IC) according to the present invention;

FIG. 85 is an explanatory diagram of a source driver circuit (IC) according to the present invention;

FIG. 86 is an explanatory diagram of a source driver circuit (IC) according to the present invention;

FIG. 87 is an explanatory diagram of a source driver circuit (IC) according to the present invention;

FIG. 88 is an explanatory diagram of a source driver circuit (IC) according to the present invention;

FIG. 89 is an explanatory diagram illustrating a drive method of a display panel according to the present invention;

FIG. 90 is an explanatory diagram illustrating a drive method of a display panel according to the present invention;

FIG. 91 is an explanatory diagram illustrating a drive method of a display panel according to the present invention;

FIG. 92 is an explanatory diagram illustrating a drive method of a display panel according to the present invention;

FIG. 93 is an explanatory diagram illustrating a drive method of a display panel according to the present invention;

FIG. 94 is an explanatory diagram illustrating a drive method of a display panel according to the present invention;

FIG. 95 is an explanatory diagram illustrating a drive method of a display panel according to the present invention;

FIG. 96 is an explanatory diagram illustrating a drive method of a display panel according to the present invention;

FIG. 97 is an explanatory diagram illustrating a drive method of a display panel according to the present invention;

FIG. 98 is an explanatory diagram illustrating a drive method of a display panel according to the present invention;

FIG. 99 is an explanatory diagram illustrating a drive method of a display panel according to the present invention;

FIG. 100 is an explanatory diagram illustrating a drive method of a display panel according to the present invention;

FIG. 101 is an explanatory diagram illustrating a drive method of a display panel according to the present invention;

FIG. 102 is an explanatory diagram illustrating a drive method of a display panel according to the present invention;

FIG. 103 is an explanatory diagram illustrating a drive method of a display panel according to the present invention;

FIG. 104 is an explanatory diagram illustrating a drive method of a display panel according to the present invention;

FIG. 105 is an explanatory diagram illustrating a drive method of a display panel according to the present invention;

FIG. 106 is an explanatory diagram illustrating a drive method of a display panel according to the present invention;

FIG. 107.is an explanatory diagram illustrating a drive method of a display panel according to the present invention;

FIG. 108 is an explanatory diagram illustrating a drive method of a display panel according to the present invention;

FIG. 109 is an explanatory diagram illustrating a drive method of a display panel according to the present invention;

FIG. 110 is an explanatory diagram illustrating a drive method of a display panel according to the present invention;

FIG. 111 is an explanatory diagram illustrating a drive method of a display panel according to the present invention;

FIG. 112 is an explanatory diagram illustrating a drive method of a display panel according to the present invention;

FIG. 113 is an explanatory diagram illustrating a drive method of a display panel according to the present invention;

FIG. 114 is an explanatory diagram illustrating a drive method of a display panel according to the present invention;

FIG. 115 is an explanatory diagram illustrating a drive method of a display panel according to the present invention;

FIG. 116 is an explanatory diagram illustrating a drive method of a display panel according to the present invention;

FIG. 117 is an explanatory diagram illustrating a drive method of a display panel according to the present invention;

FIG. 118 is an explanatory diagram illustrating a drive method of a display panel according to the present invention;

FIG. 119 is an explanatory diagram illustrating a drive method of a display panel according to the present invention;

FIG. 120 is an explanatory diagram illustrating a drive method of a display panel according to the present invention;

FIG. 121 is an explanatory diagram illustrating a drive method of a display panel according to the present invention;

FIG. 122 is an explanatory diagram illustrating a drive method of a display panel according to the present invention;

FIG. 123 is an explanatory diagram illustrating a drive method of a display panel according to the present invention;

FIG. 124 is an explanatory diagram illustrating a drive method of a display panel according to the present invention;

FIG. 125 is an explanatory diagram illustrating a drive method of a display panel according to the present invention;

FIG. 126 is an explanatory diagram of a display apparatus according to the present invention;

FIG. 127 is an explanatory diagram of a source driver circuit (IC) according to the present invention;

FIG. 128 is an explanatory diagram of a source driver circuit (IC) according to the present invention;

FIG. 129 is an explanatory diagram of a source driver circuit (IC) according to the present invention;

FIG. 130 is an explanatory diagram of a source driver circuit (IC) according to the present invention;

FIG. 131 is an explanatory diagram of a source driver circuit (IC) according to the present invention;

FIG. 132 is an explanatory diagram of a source driver circuit (IC) according to the present invention;

FIG. 133 is an explanatory diagram of a source driver circuit (IC) according to the present invention;

FIG. 134 is an explanatory diagram of a source driver circuit (IC) according to the present invention;

FIG. 135 is an explanatory diagram of a source driver circuit (IC) according to the present invention;

FIG. 136 is an explanatory diagram of a source driver circuit (IC) according to the present invention;

FIG. 137 is an explanatory diagram of a source driver circuit (IC) according to the present invention;

FIG. 138 is an explanatory diagram of a source driver circuit (IC) according to the present invention;

FIG. 139 is an explanatory diagram of a source driver circuit (IC) according to the present invention;

FIG. 140 is an explanatory diagram of a source driver circuit (IC) according to the present invention;

FIG. 141 is an explanatory diagram of a source driver circuit (IC) according to the present invention;

FIG. 142 is an explanatory diagram of a source driver circuit (IC) according to the present invention;

FIG. 143 is an explanatory diagram of a source driver circuit (IC) according to the present invention;

FIG. 144 is an explanatory diagram of a source driver circuit (IC) according to the present invention;

FIG. 145 is an explanatory diagram of a source driver circuit (IC) according to the present invention;

FIG. 146 is an explanatory diagram of a source driver circuit (IC) according to the present invention;

FIG. 147 is an explanatory diagram of a source driver circuit (IC) according to the present invention;

FIG. 148 is an explanatory diagram of a source driver circuit (IC) according to the present invention;

FIG. 149 is an explanatory diagram of a source driver circuit (IC) according to the present invention;

FIG. 150 is an explanatory diagram of a source driver circuit (IC) according to the present invention;

FIG. 151 is an explanatory diagram of a source driver circuit (IC) according to the present invention;

FIG. 152 is an explanatory diagram of a source driver circuit (IC) according to the present invention;

FIG. 153 is an explanatory diagram of a source driver circuit (IC) according to the present invention;

FIG. 154 is an explanatory diagram of a display apparatus according to the present invention;

FIG. 155 is an explanatory diagram of a display apparatus according to the present invention;

FIG. 156 is an explanatory diagram of a display apparatus according to the present invention;

FIG. 157 is an explanatory diagram of a display apparatus according to the present invention;

FIG. 158 is an explanatory diagram of a display apparatus according to the present invention;

FIG. 159 is an explanatory diagram of a source driver circuit (IC) according to the present invention;

FIG. 160 is an explanatory diagram of a source driver circuit (IC) according to the present invention;

FIG. 161 is an explanatory diagram of a source driver circuit (IC) according to the present invention;

FIG. 162 is an explanatory diagram of a source driver circuit (IC) according to the present invention;

FIG. 163 is an explanatory diagram of a source driver circuit (IC) according to the present invention;

FIG. 164 is an explanatory diagram of a source driver circuit (IC) according to the present invention;

FIG. 165 is an explanatory diagram of a source driver circuit (IC) according to the present invention;

FIG. 166 is an explanatory diagram of a source driver circuit (IC) according to the present invention;

FIG. 167 is an explanatory diagram of a source driver circuit (IC) according to the present invention;

FIG. 168 is an explanatory diagram of a source driver circuit (IC) according to the present invention;

FIG. 169 is an explanatory diagram of a source driver circuit (IC) according to the present invention;

FIG. 170 is an explanatory diagram of a source driver circuit (IC) according to the present invention;

FIG. 171 is an explanatory diagram of a source driver circuit (IC) according to the present invention;

FIG. 172 is an explanatory diagram of a source driver circuit (IC) according to the present invention;

FIG. 173 is an explanatory diagram of a source driver circuit (IC) according to the present invention;

FIG. 174 is an explanatory diagram of a source driver circuit (IC) according to the present invention;

FIG. 175 is an explanatory diagram of a source driver circuit (IC) according to the present invention;

FIG. 176 is an explanatory diagram of a source driver circuit (IC) according to the present invention;

FIG. 177 is an explanatory diagram illustrating a drive method of a display panel according to the present invention;

FIG. 178 is an explanatory diagram illustrating a drive method of a display panel according to the present invention;

FIG. 179 is an explanatory diagram illustrating a drive method of a display panel according to the present invention;

FIG. 180 is an explanatory diagram of a display panel according to the present invention;

FIG. 181 is an explanatory diagram of a display panel according to the present invention;

FIG. 182 is an explanatory diagram of a source driver circuit (IC) according to the present invention;

FIG. 183 is an explanatory diagram of a source driver circuit (IC) according to the present invention;

FIG. 184 is an explanatory diagram of a source driver circuit (IC) according to the present invention;

FIG. 185 is an explanatory diagram of a source driver circuit (IC) according to the present invention;

FIG. 186 is an explanatory diagram illustrating a drive method of a display panel according to the present invention;

FIG. 187 is an explanatory diagram illustrating a drive method of a display panel according to the present invention;

FIG. 188 is an explanatory diagram of a source driver circuit (IC) according to the present invention;

FIG. 189 is an explanatory diagram of a source driver circuit (IC) according to the present invention;

FIG. 190 is an explanatory diagram of a source driver circuit (IC) according to the present invention;

FIG. 191 is an explanatory diagram of a display panel according to the present invention;

FIG. 192 is an explanatory diagram illustrating a drive method of a display panel according to the present invention;

FIG. 193 is an explanatory diagram of a display panel according to the present invention;

FIG. 194 is an explanatory diagram of a display panel according to the present invention;

FIG. 195 is an explanatory diagram of a display panel according to the present invention;

FIG. 196 is an explanatory diagram of a source driver circuit (IC) according to the present invention;

FIG. 197 is an explanatory diagram of a source driver circuit (IC) according to the present invention;

FIG. 198 is an explanatory diagram of a source driver circuit (IC) according to the present invention;

FIG. 199 is an explanatory diagram of a source driver circuit (IC) according to the present invention;

FIG. 200 is an explanatory diagram of a source driver circuit (IC) according to the present invention;

FIG. 201 is an explanatory diagram of a source driver circuit (IC) according to the present invention;

FIG. 202 is an explanatory diagram illustrating a checking method of a display panel (array) according to the present invention;

FIG. 203 is an explanatory diagram illustrating a checking method of a display panel (array) according to the present invention;

FIG. 204 is an explanatory diagram illustrating a checking method of a display panel (array) according to the present invention;

FIG. 205 is an explanatory diagram illustrating a checking method of a display panel (array) according to the present invention;

FIG. 206 is an explanatory diagram illustrating a checking method of a display panel (array) according to the present invention;

FIG. 207 is an explanatory diagram illustrating a checking method of a display panel (array) according to the present invention;

FIG. 208 is an explanatory diagram of a display panel according to the present invention;

FIG. 209 is an explanatory diagram of a display panel according to the present invention;

FIG. 210 is an explanatory diagram of a source driver circuit (IC) according to the present invention;

FIG. 211 is an explanatory diagram illustrating a drive method of a display panel according to the present invention;

FIG. 212 is an explanatory diagram illustrating a drive method of a display panel according to the present invention;

FIG. 213 is an explanatory diagram illustrating a drive method of a display panel according to the present invention;

FIG. 214 is an explanatory diagram illustrating a drive method of a display panel according to the present invention;

FIG. 215 is an explanatory diagram illustrating a drive method of a display panel according to the present invention;

FIG. 216 is an explanatory diagram illustrating a drive method of a display panel according to the present invention;

FIG. 217 is an explanatory diagram illustrating a drive method of a display panel according to the present invention;

FIG. 218 is an explanatory diagram illustrating a drive method of a display panel according to the present invention;

FIG. 219 is an explanatory diagram illustrating a drive method of a display panel according to the present invention;

FIG. 220 is an explanatory diagram illustrating a drive method of a display panel according to the present invention;

FIG. 221 is an explanatory diagram illustrating a drive method of a display panel according to the present invention;

FIG. 222 is an explanatory diagram illustrating a drive method of a display panel according to the present invention;

FIG. 223 is an explanatory diagram illustrating a checking method of a display panel (array) according to the present invention;

FIG. 224 is an explanatory diagram illustrating a checking method of a display panel (array) according to the present invention;

FIG. 225 is an explanatory diagram illustrating a checking method of a display panel (array) according to the present invention;

FIG. 226 is an explanatory diagram illustrating a checking method of a display panel (array) according to the present invention;

FIG. 227 is an explanatory diagram illustrating a checking method of a display panel (array) according to the present invention;

FIG. 228 is an explanatory diagram of a source driver circuit (IC) according to the present invention;

FIG. 229 is an explanatory diagram of a source driver circuit (IC) according to the present invention;

FIG. 230 is an explanatory diagram of a source driver circuit (IC) according to the present invention;

FIG. 231 is an explanatory diagram of a source driver circuit (IC) according to the present invention;

FIG. 232 is an explanatory diagram of a source driver circuit (IC) according to the present invention;

FIG. 233 is an explanatory diagram of a source driver circuit (IC) according to the present invention;

FIG. 234 is an explanatory diagram of a source driver circuit (IC) according to the present invention;

FIG. 235 is an explanatory diagram of a display panel according to the present invention;

FIG. 236 is an explanatory diagram illustrating a drive method of a display panel according to the present invention;

FIG. 237 is an explanatory diagram of a source driver circuit (IC) according to the present invention;

FIG. 238 is an explanatory diagram illustrating a drive method of a display panel according to the present invention;

FIG. 239 is an explanatory diagram illustrating a drive method of a display panel according to the present invention;

FIG. 240 is an explanatory diagram of a source driver circuit (IC) according to the present invention;

FIG. 241 is an explanatory diagram of a source driver circuit (IC) according to the present invention;

FIG. 242 is an explanatory diagram of a source driver circuit (IC) according to the present invention;

FIG. 243 is an explanatory diagram of a source driver circuit (IC) according to the present invention;

FIG. 244 is an explanatory diagram of a source driver circuit (IC) according to the present invention;

FIG. 245 is an explanatory diagram of a source driver circuit (IC) according to the present invention;

FIG. 246 is an explanatory diagram of a source driver circuit (IC) according to the present invention;

FIG. 247 is an explanatory diagram of a source driver circuit (IC) according to the present invention;

FIG. 248 is an explanatory diagram of a source driver circuit (IC) according to the present invention;

FIG. 249 is an explanatory diagram of a source driver circuit (IC) according to the present invention;

FIG. 250 is an explanatory diagram of a source driver circuit (IC) according to the present invention;

FIG. 251 is an explanatory diagram of display panel according to the present invention;

FIG. 252 is an explanatory diagram illustrating a drive method of a display panel according to the present invention;

FIG. 253 is an explanatory diagram illustrating a drive method of a display panel according to the present invention;

FIG. 254 is an explanatory diagram illustrating a drive method of a display panel according to the present invention;

FIG. 255 is an explanatory diagram illustrating a drive method of a display panel according to the present invention;

FIG. 256 is an explanatory diagram illustrating a drive method of a display panel according to the present invention;

FIG. 257 is an explanatory diagram illustrating a drive method of a display panel according to the present invention;

FIG. 258 is an explanatory diagram illustrating a drive method of a display panel according to the present invention;

FIG. 259 is an explanatory diagram illustrating a drive method of a display panel according to the present invention;

FIG. 260 is an explanatory diagram of a display panel according to the present invention;

FIG. 261 is an explanatory diagram of a display panel according to the present invention;

FIG. 262 is an explanatory diagram of a display panel according to the present invention;

FIG. 263 is an explanatory diagram of a display panel according to the present invention;

FIG. 264 is an explanatory diagram of a display panel according to the present invention;

FIG. 265 is an explanatory diagram of a display panel according to the present invention;

FIG. 266 is an explanatory diagram illustrating a drive method of a display panel according to the present invention;

FIG. 267 is an explanatory diagram illustrating a drive method of a display panel according to the present invention;

FIG. 268 is an explanatory diagram illustrating a drive method of a display panel according to the present invention;

FIG. 269 is an explanatory diagram illustrating a drive method of a display panel according to the present invention;

FIG. 270 is an explanatory diagram illustrating a drive method of a display panel according to the present invention;

FIG. 271 is an explanatory diagram illustrating a drive method of a display panel according to the present invention;

FIG. 272 is an explanatory diagram illustrating a drive method of a display panel according to the present invention;

FIG. 273 is an explanatory diagram illustrating a drive method of a display panel according to the present invention;

FIG. 274 is an explanatory diagram illustrating a drive method of a display panel according to the present invention;

FIG. 275 is an explanatory diagram illustrating a drive method of a display panel according to the present invention;

FIG. 276 is an explanatory diagram illustrating a drive method of a display panel according to the present invention;

FIG. 277 is an explanatory diagram illustrating a drive method of a display panel according to the present invention;

FIG. 278 is an explanatory diagram illustrating a drive method of a display panel according to the present invention;

FIG. 279 is an explanatory diagram illustrating a drive method of a display panel according to the present invention;

FIG. 280 is an explanatory diagram illustrating a drive method of a display panel according to the present invention;

FIG. 281 is an explanatory diagram of a display panel according to the present invention;

FIG. 282 is an explanatory diagram of a display panel according to the present invention;

FIG. 283 is an explanatory diagram of a source driver circuit (IC) according to the present invention;

FIG. 284 is an explanatory diagram of a source driver circuit (IC) according to the present invention;

FIG. 285 is an explanatory diagram of a source driver circuit (IC) according to the present invention;

FIG. 286 is an explanatory diagram of a source driver circuit (IC) according to the present invention;

FIG. 287 is an explanatory diagram of a source driver circuit (IC) according to the present invention;

FIG. 288 is an explanatory diagram of a source driver circuit (IC) according to the present invention;

FIG. 289 is an explanatory diagram of a source driver circuit (IC) according to the present invention;

FIG. 290 is an explanatory diagram of a source driver circuit (IC) according to the present invention;

FIG. 291 is an explanatory diagram of a source driver circuit (IC) according to the present invention;

FIG. 292 is an explanatory diagram of a source driver circuit (IC) according to the present invention;

FIG. 293 is an explanatory diagram of a source driver circuit (IC) according to the present invention;

FIG. 294 is an explanatory diagram of a source driver circuit (IC) according to the present invention;

FIG. 295 is an explanatory diagram of a source driver circuit (IC) according to the present invention;

FIG. 296 is an explanatory diagram of a source driver circuit (IC) according to the present invention;

FIG. 297 is an explanatory diagram of a source driver circuit (IC) according to the present invention;

FIG. 298 is an explanatory diagram of a source driver circuit (IC) according to the present invention;

FIG. 299 is an explanatory diagram of a source driver circuit (IC) according to the present invention;

FIG. 300 is an explanatory diagram of a source driver circuit (IC) according to the present invention;

FIG. 301 is an explanatory diagram of a source driver circuit (IC) according to the present invention;

FIG. 302 is an explanatory diagram of a source driver circuit (IC) according to the present invention;

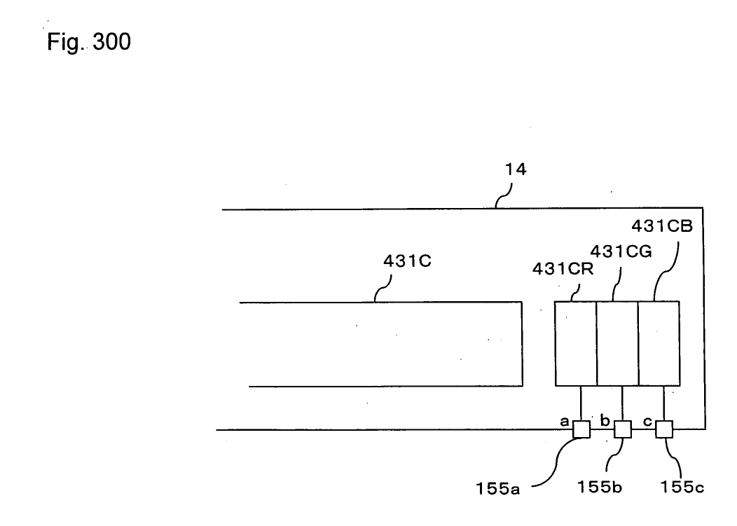

FIG. 300 is an explanatory diagram of a source driver circuit (IC) according to the present invention;

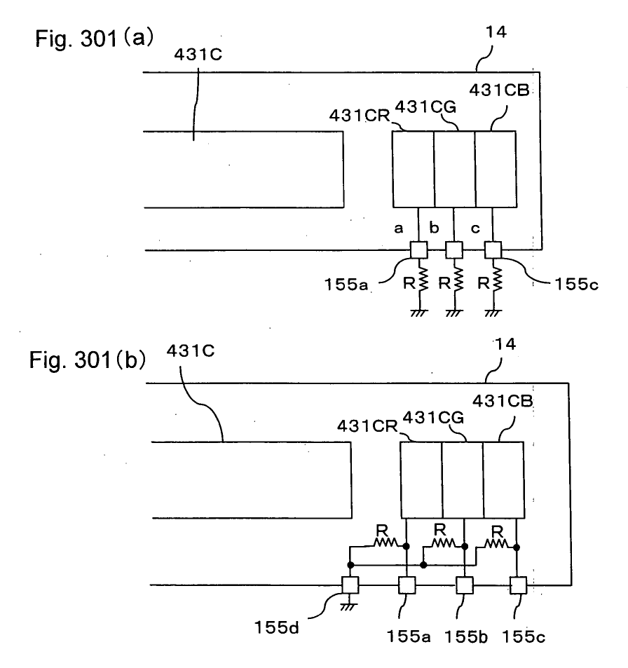

FIG. 301 is an explanatory diagram of a source driver circuit (IC) according to the present invention;

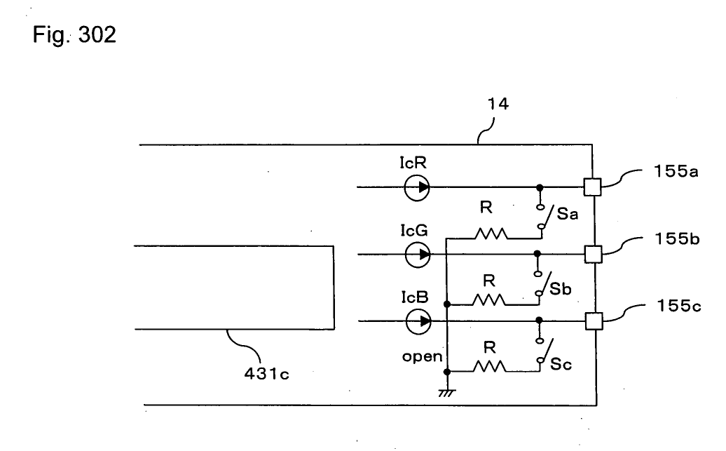

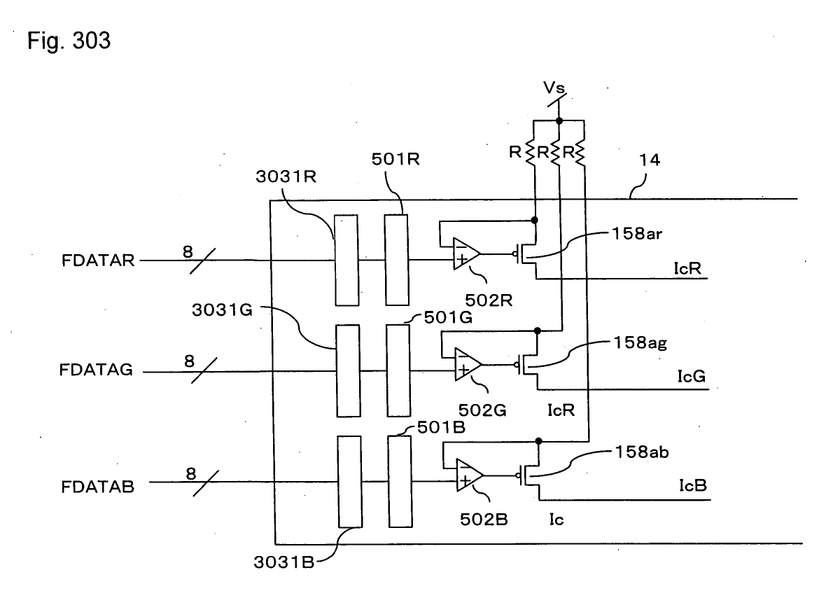

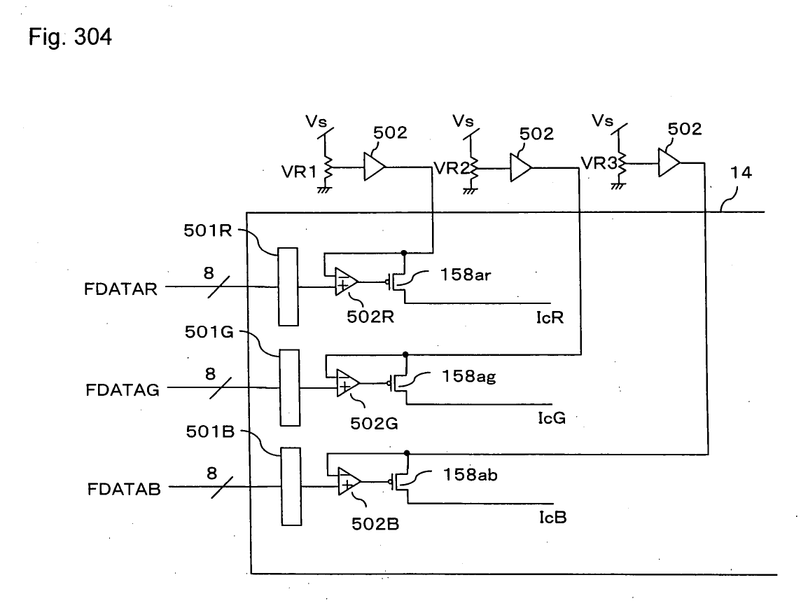

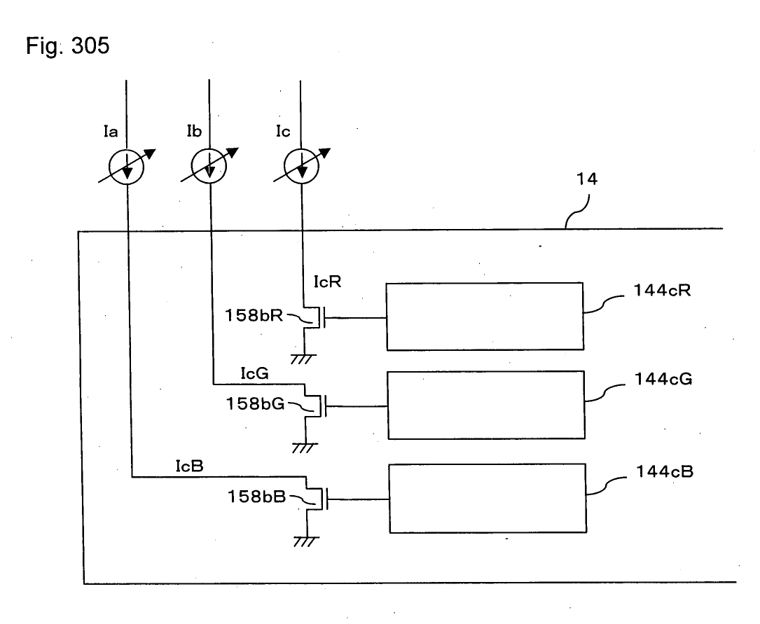

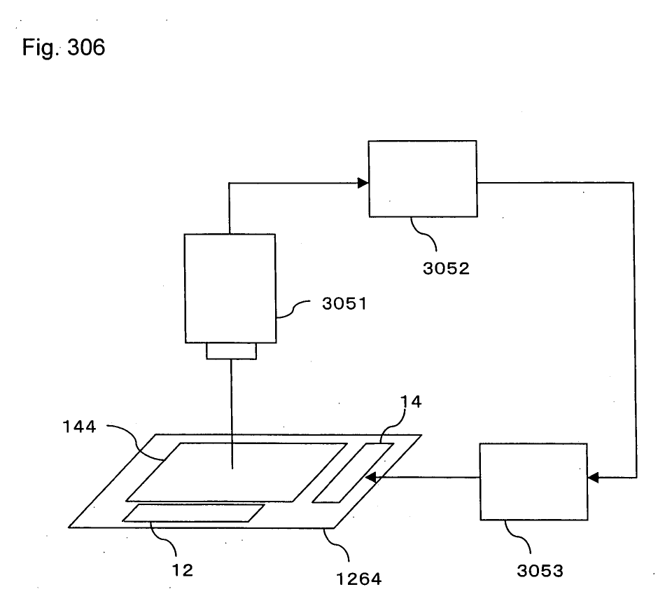

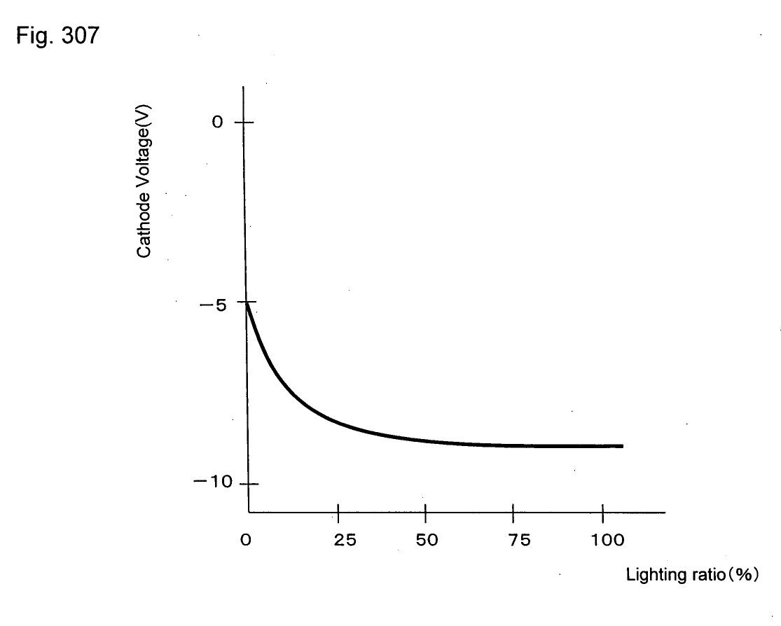

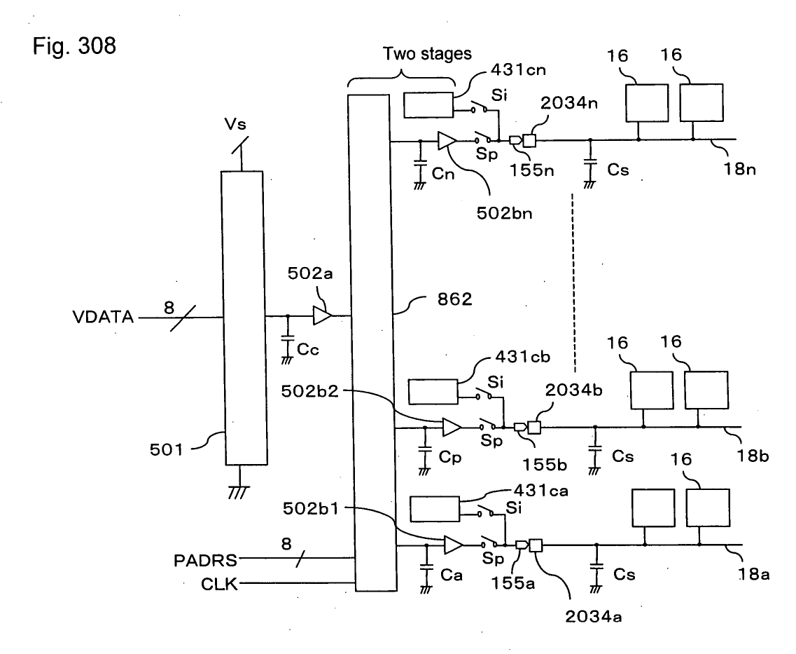

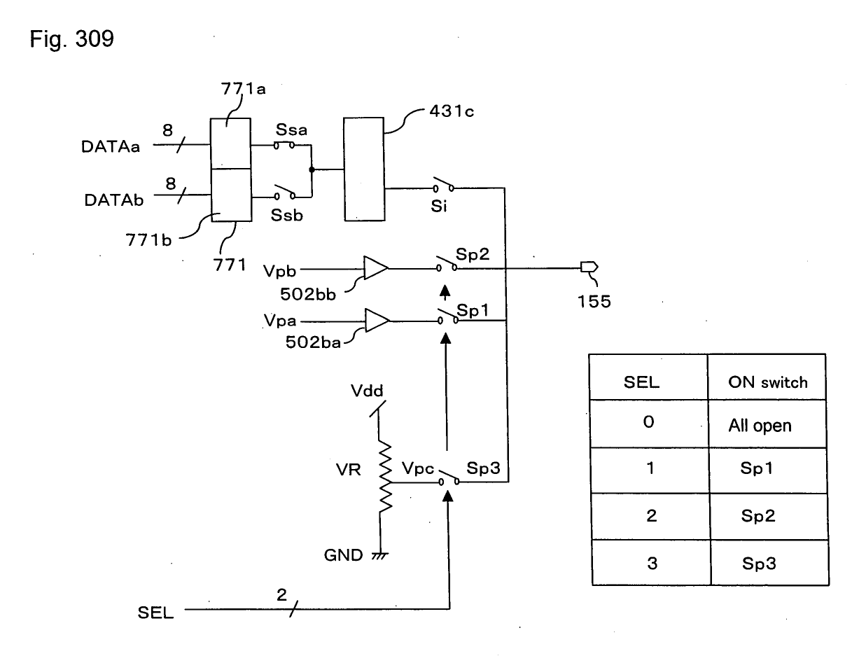

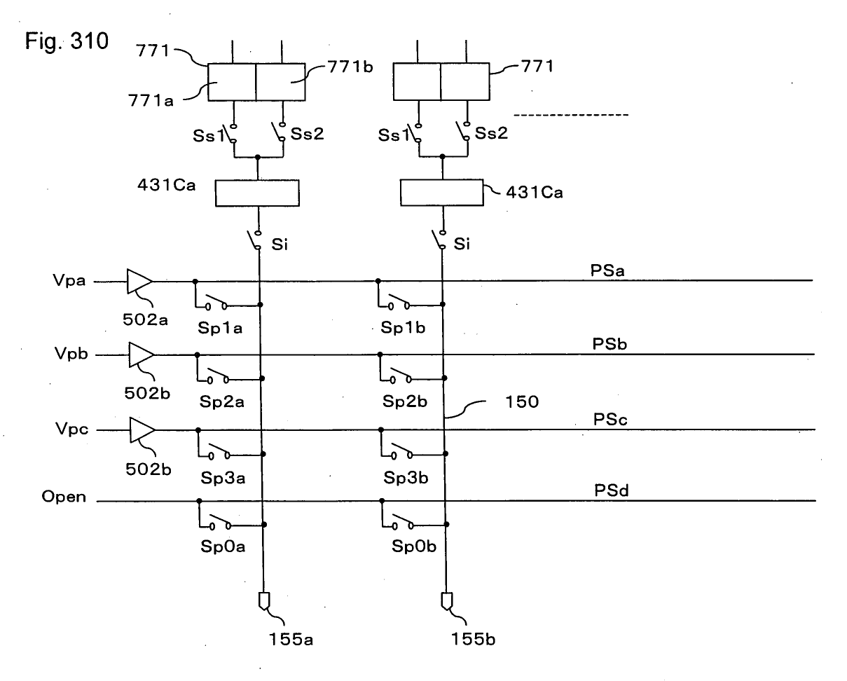

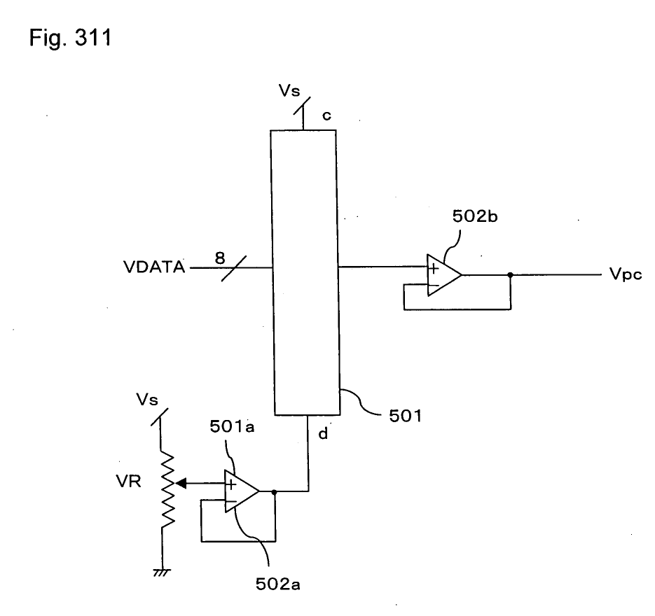

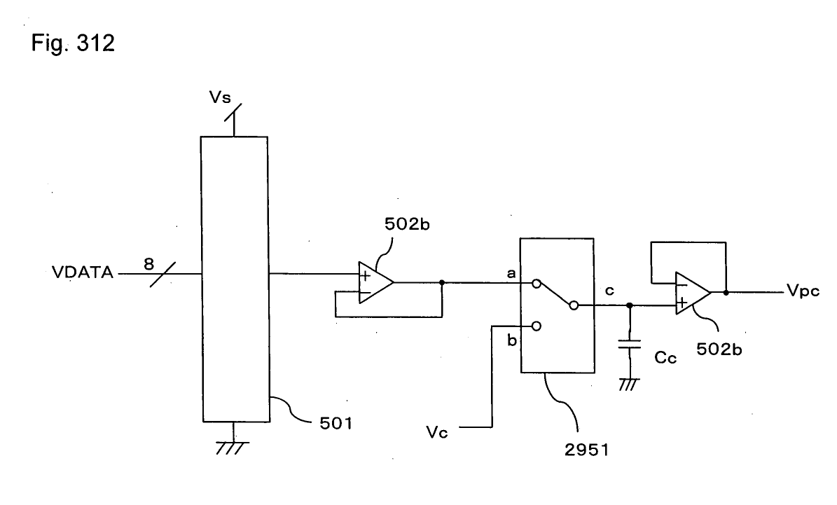

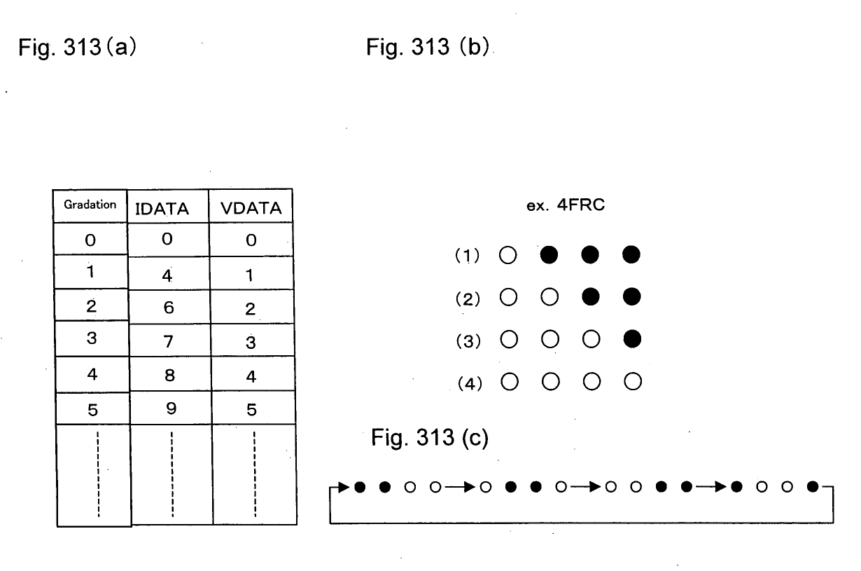

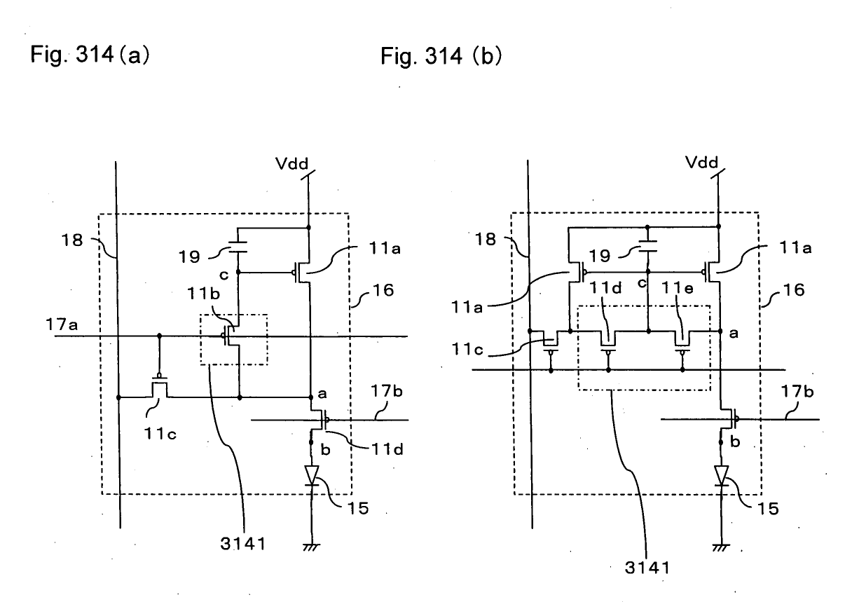

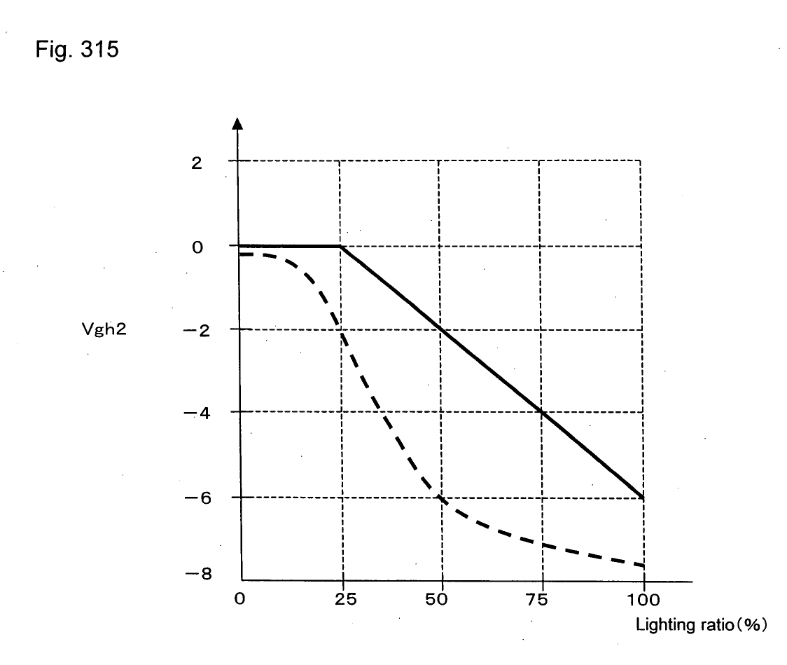

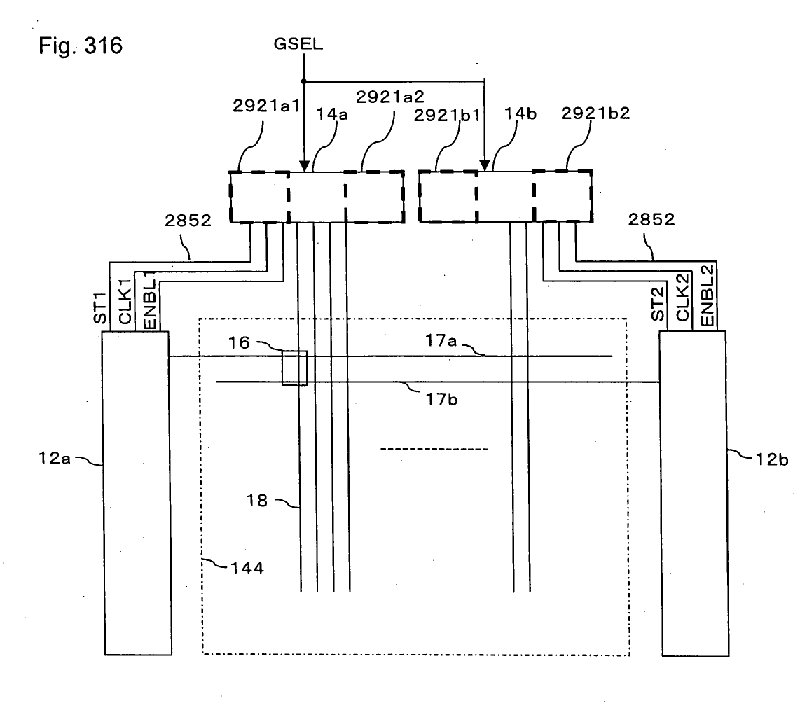

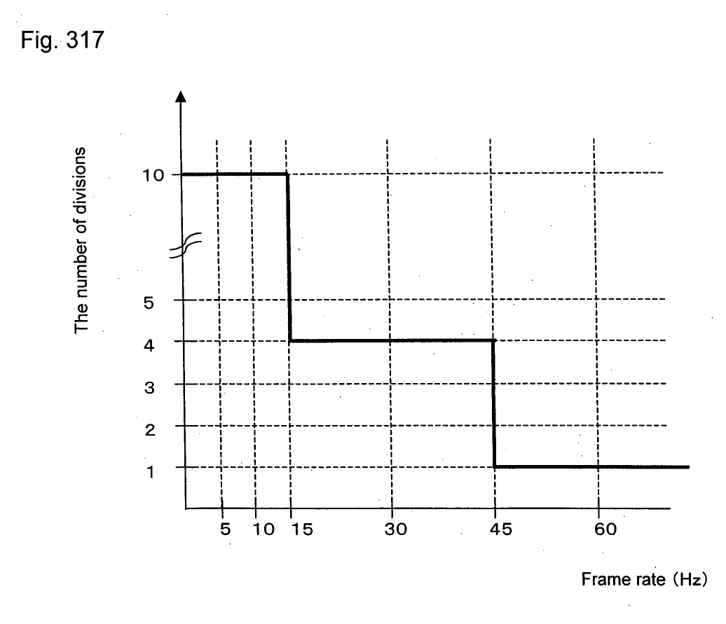

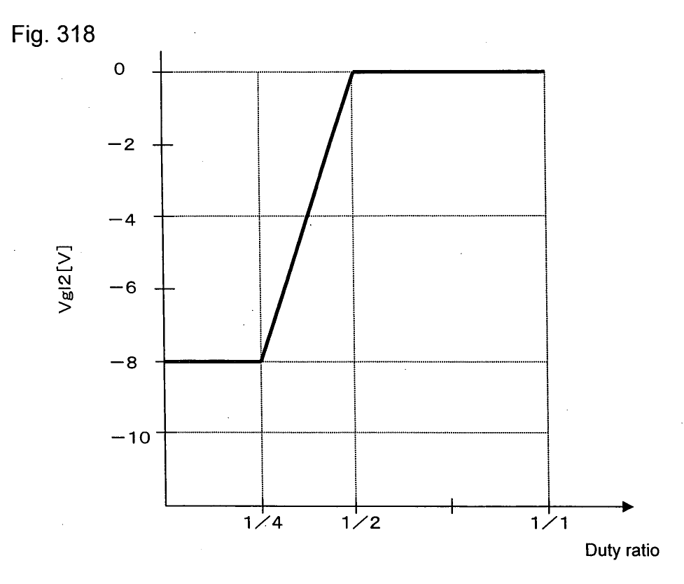

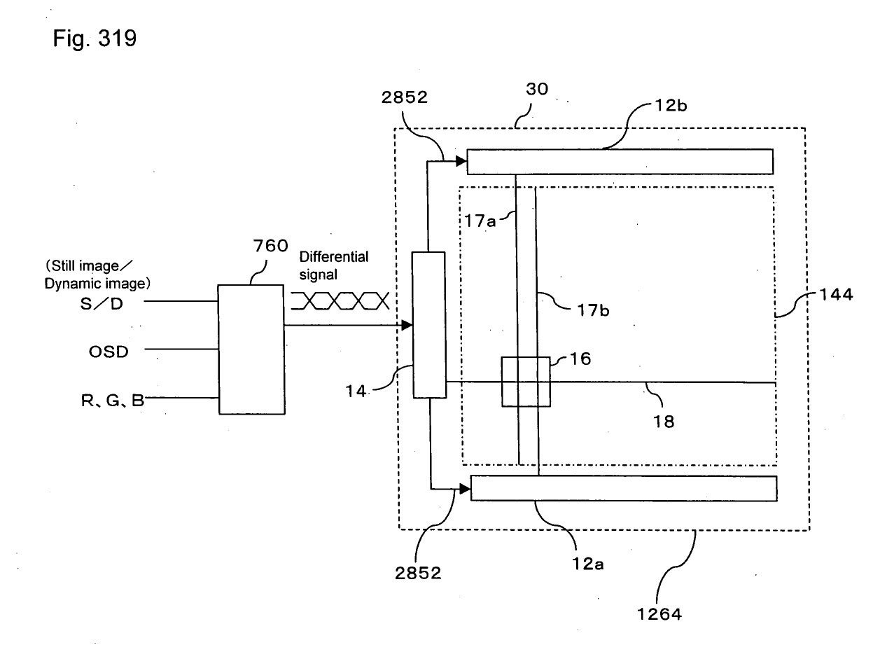

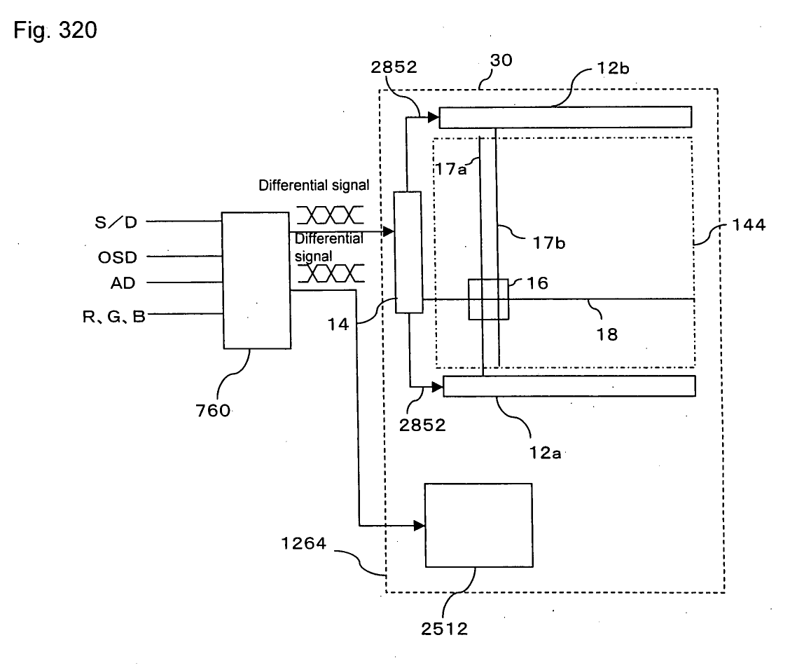

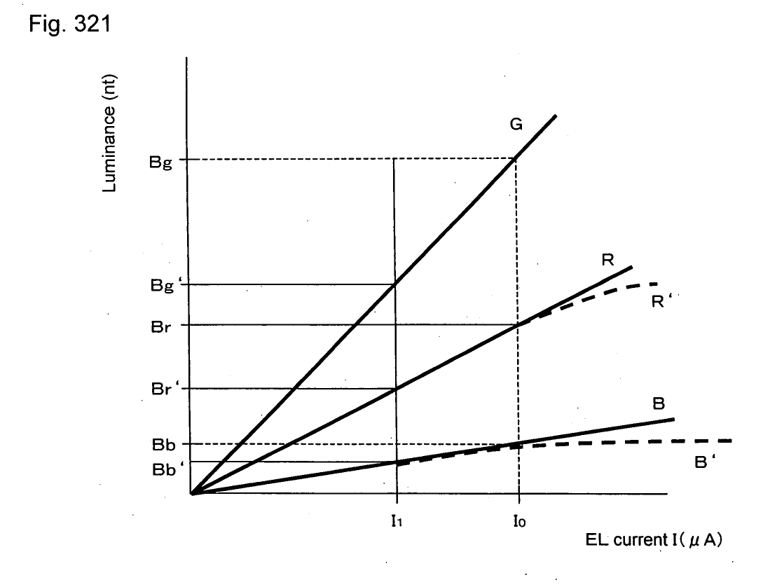

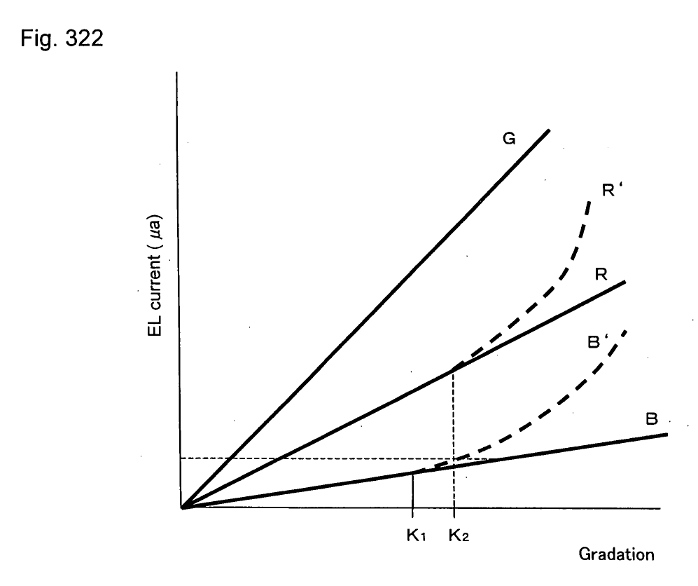

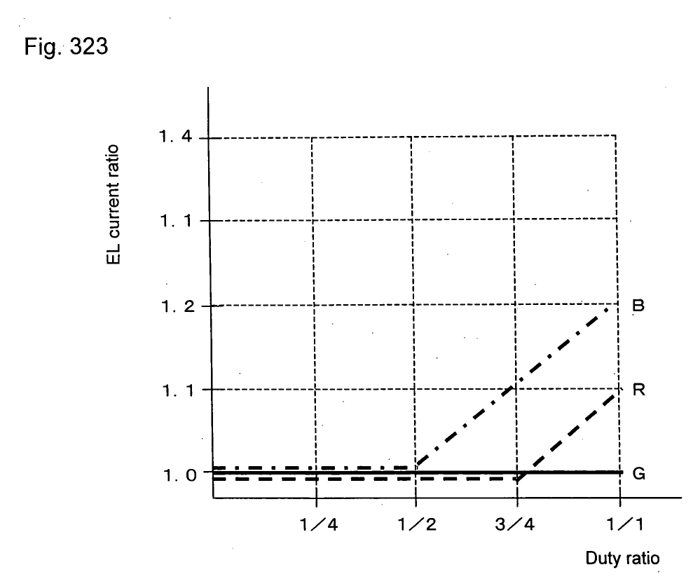

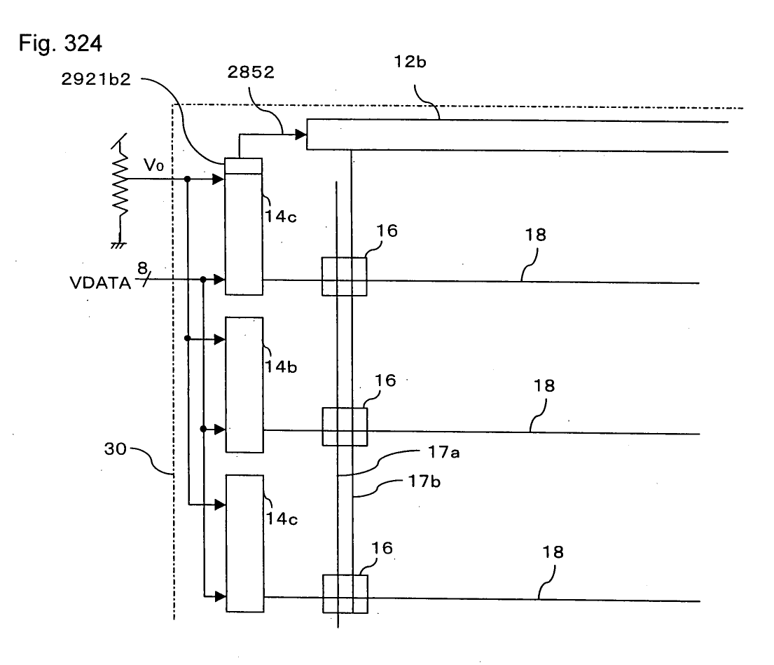

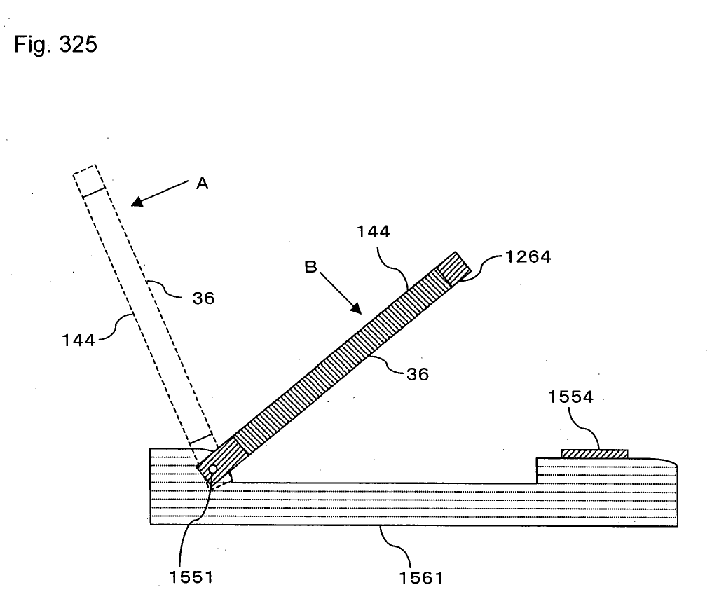

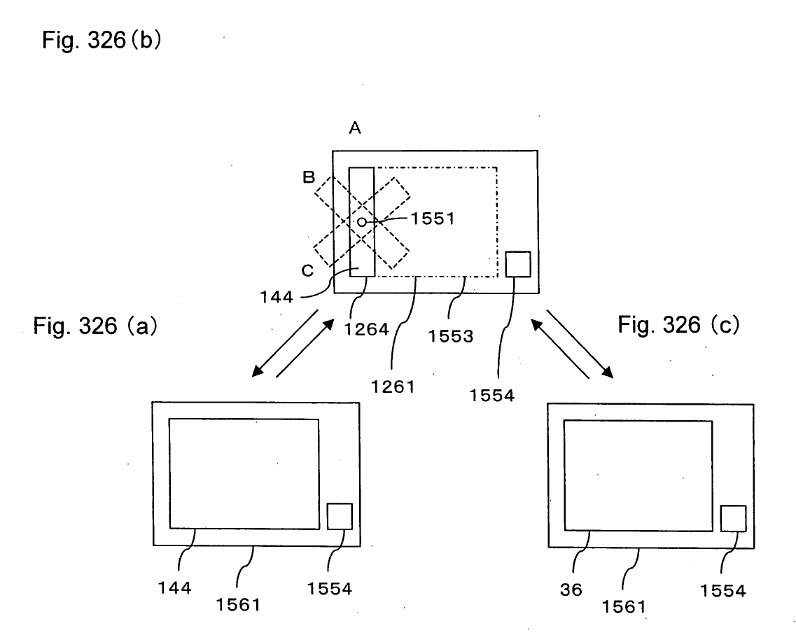

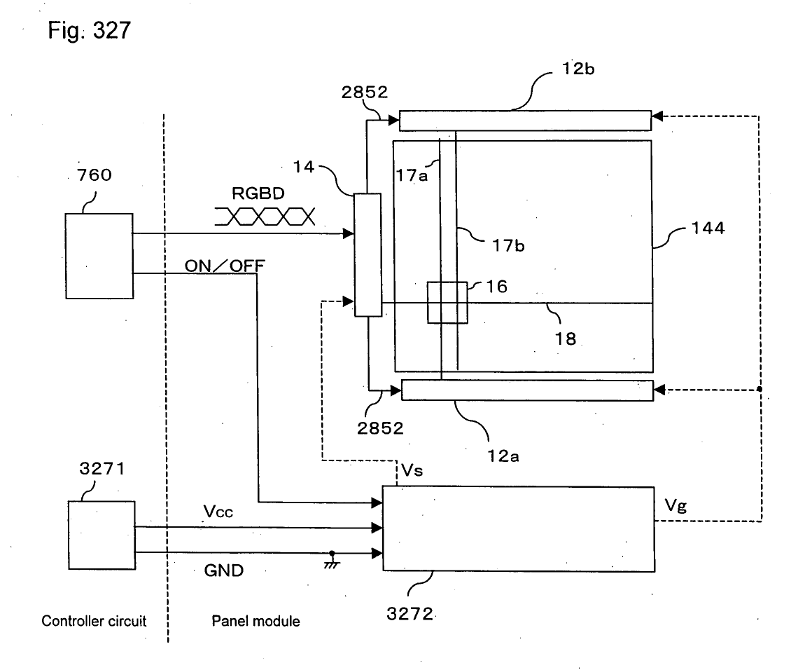

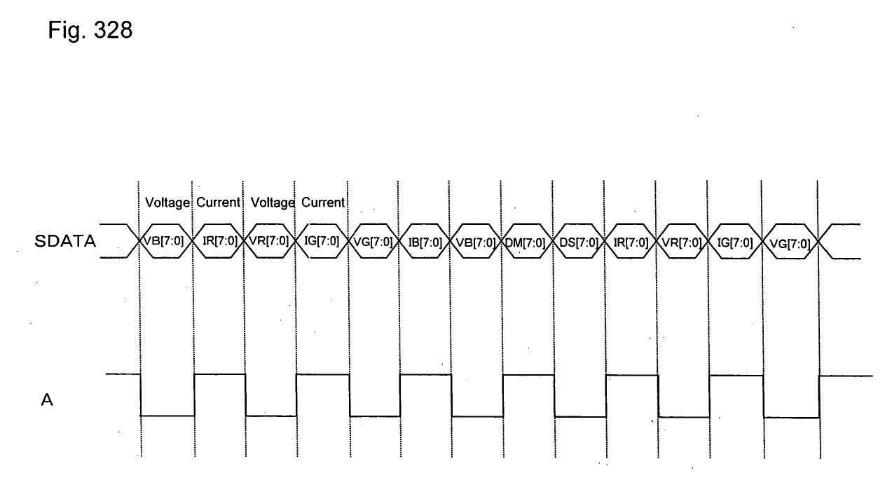

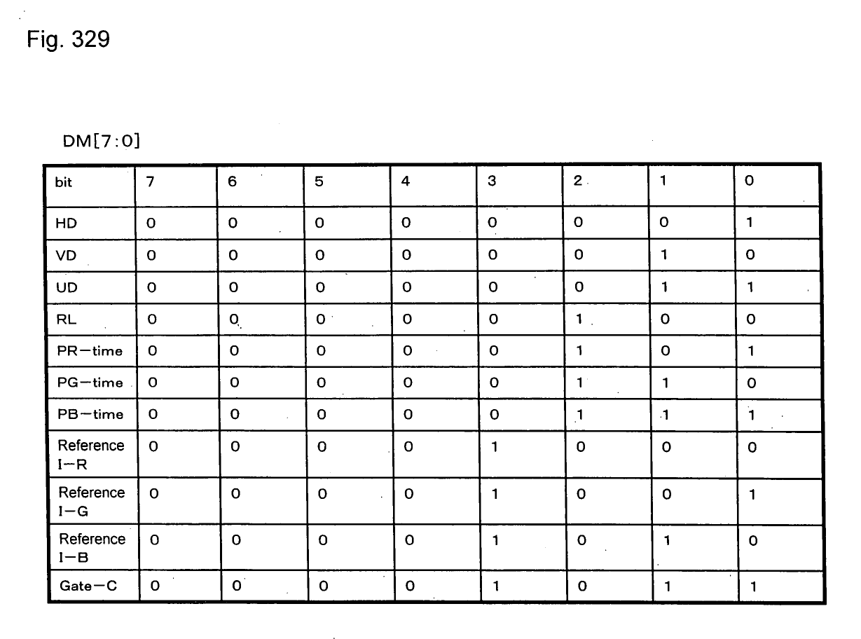

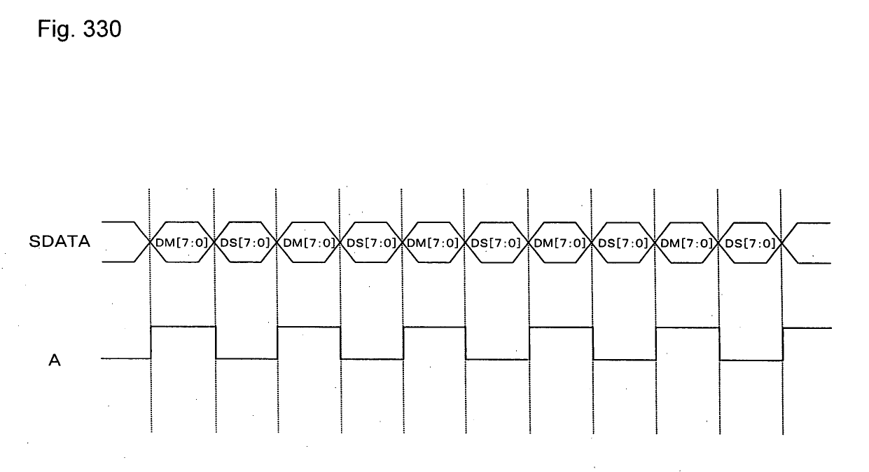

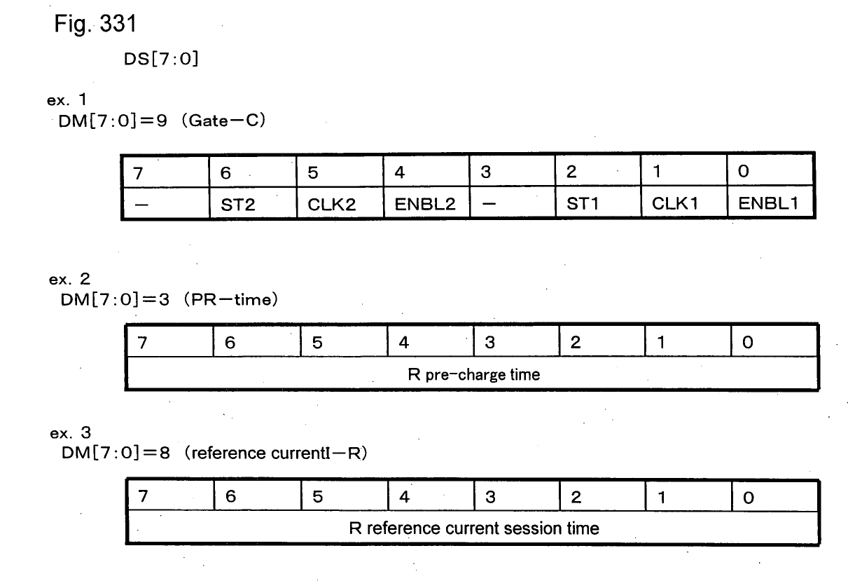

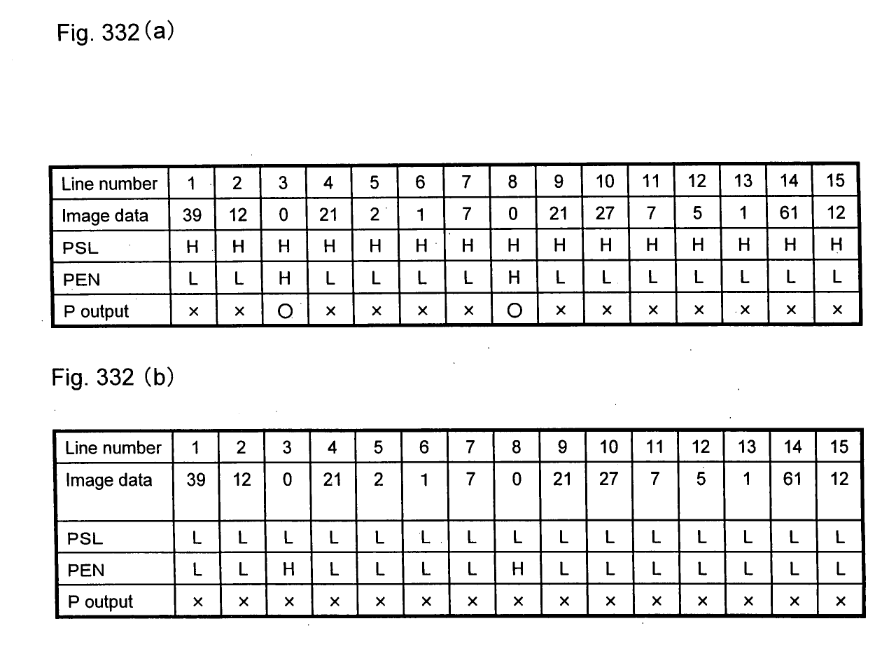

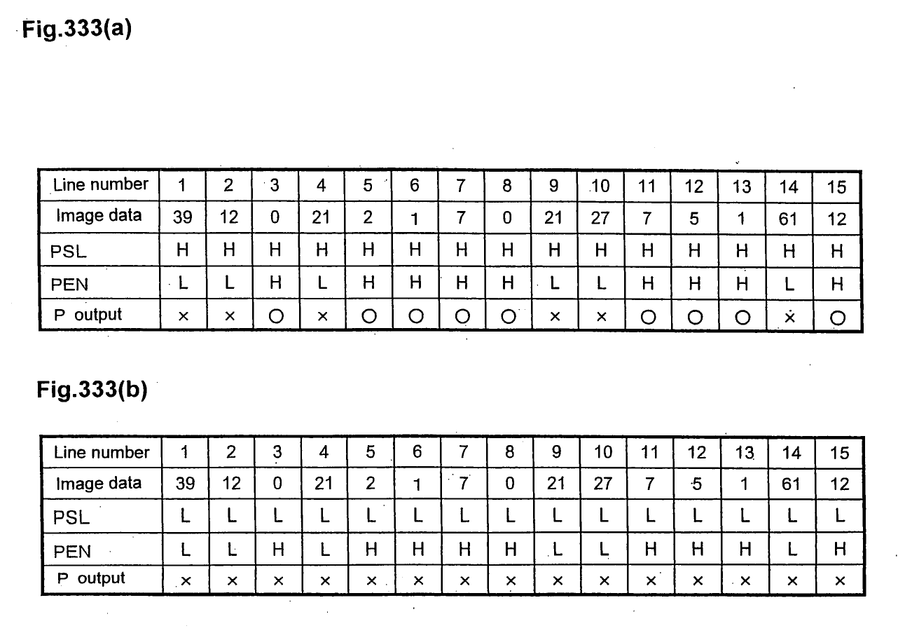

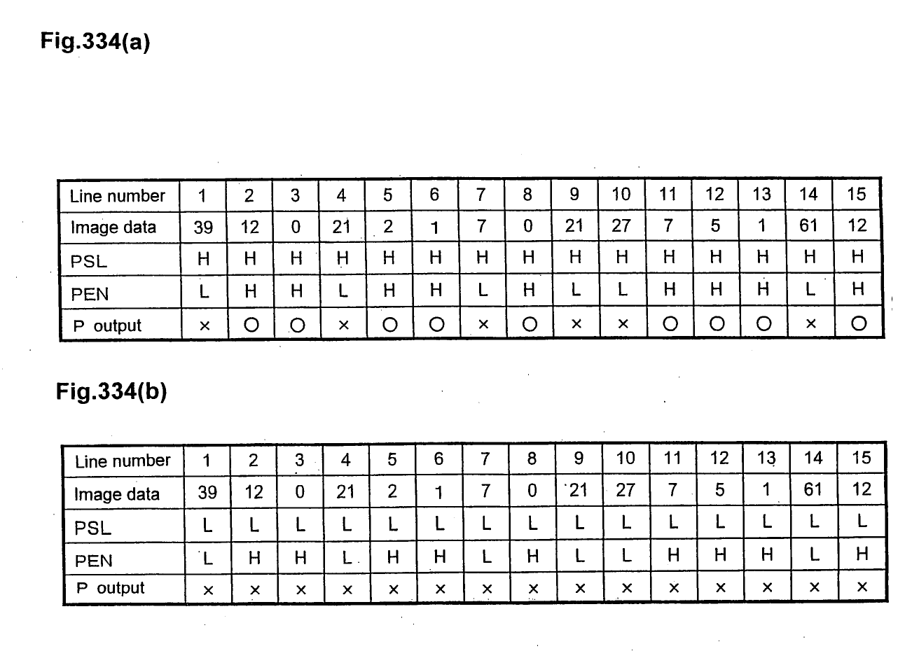

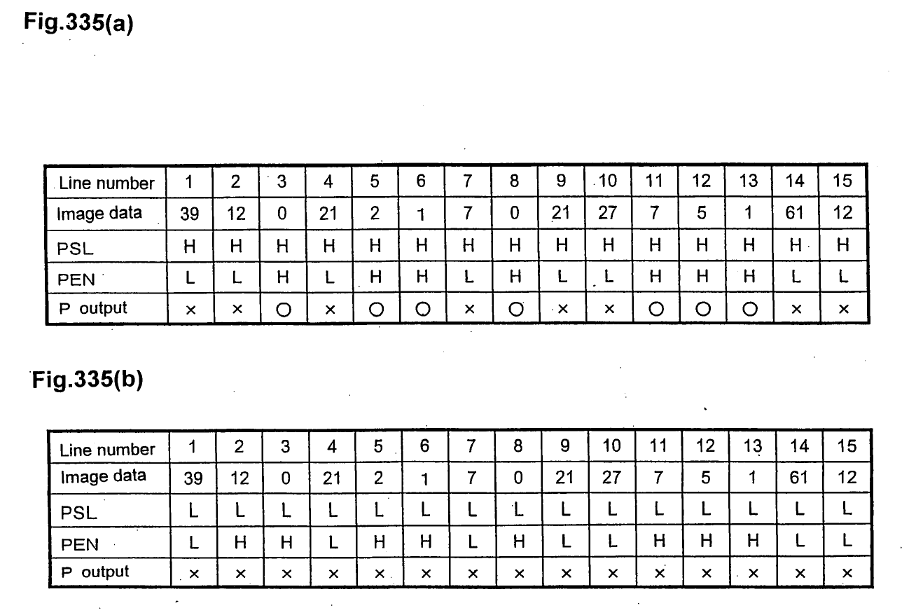

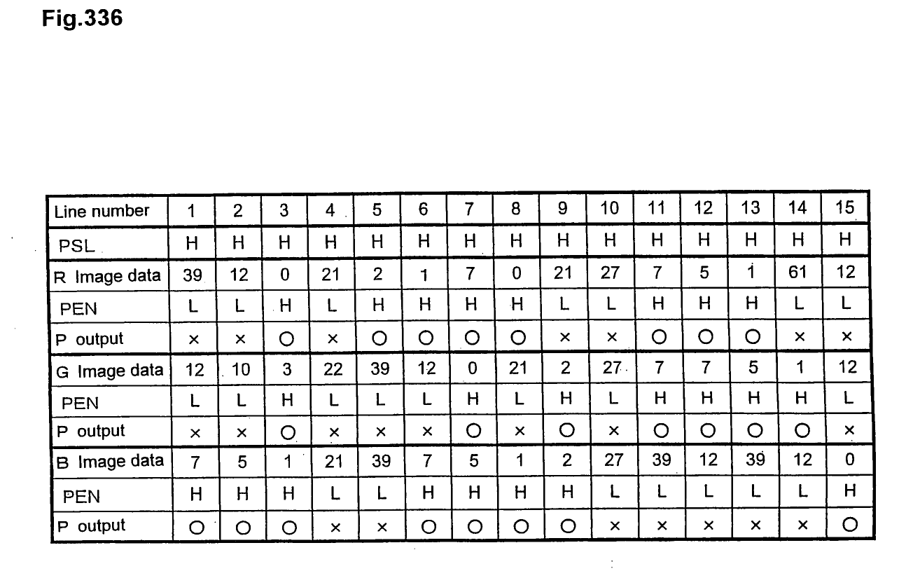

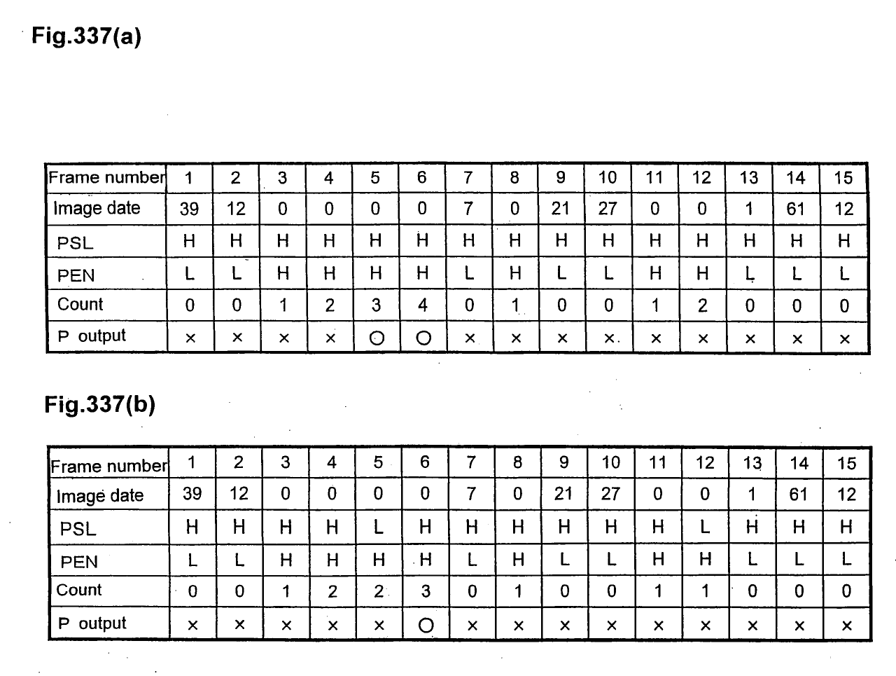

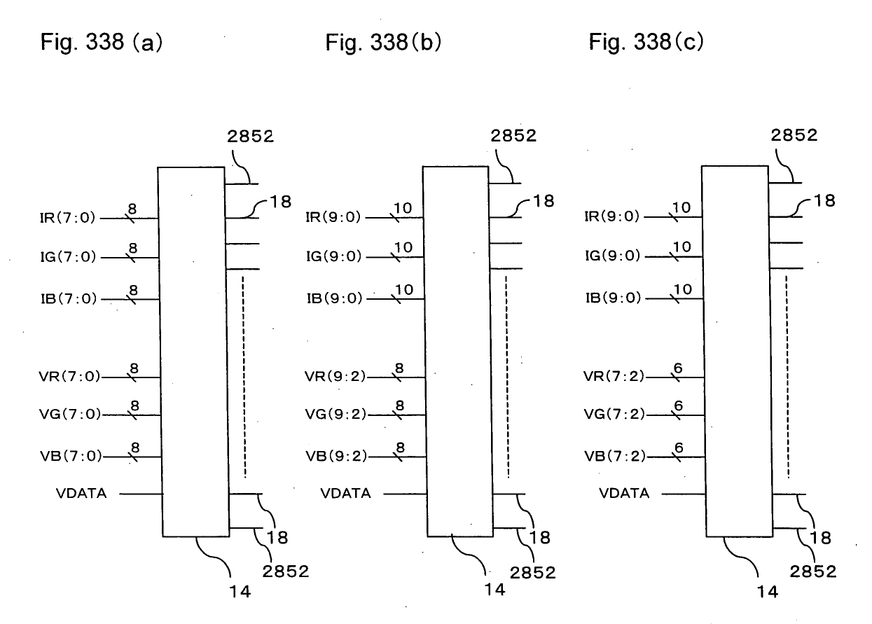

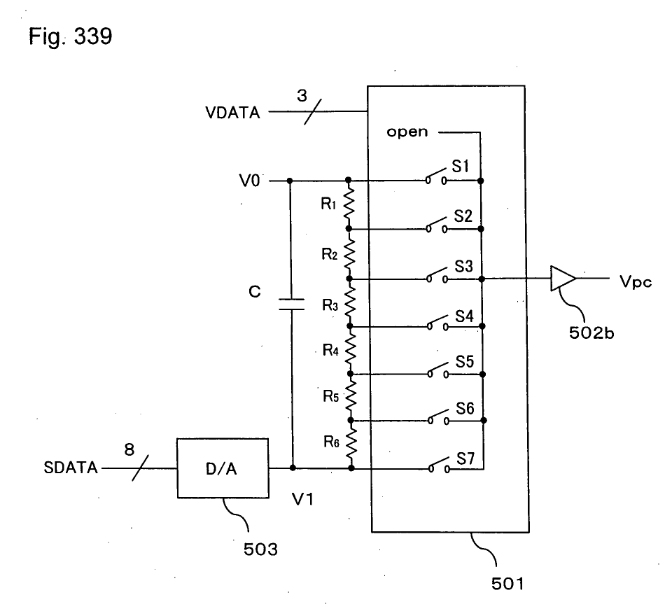

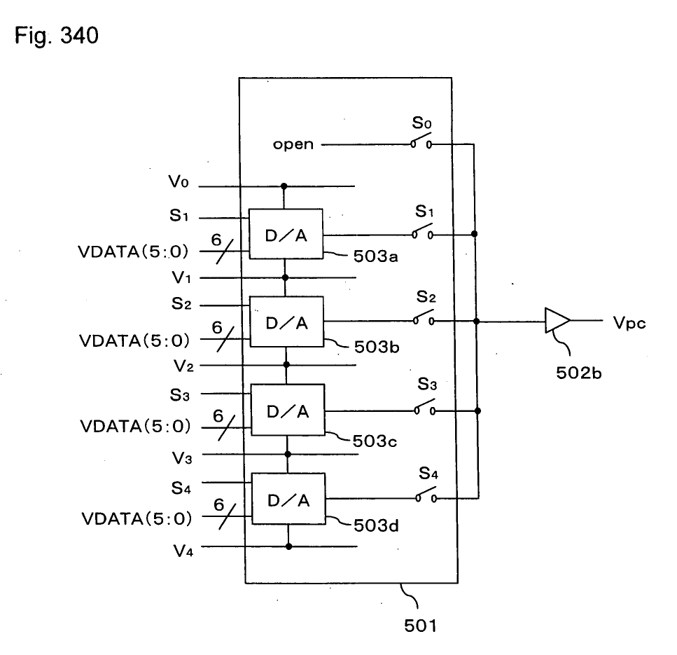

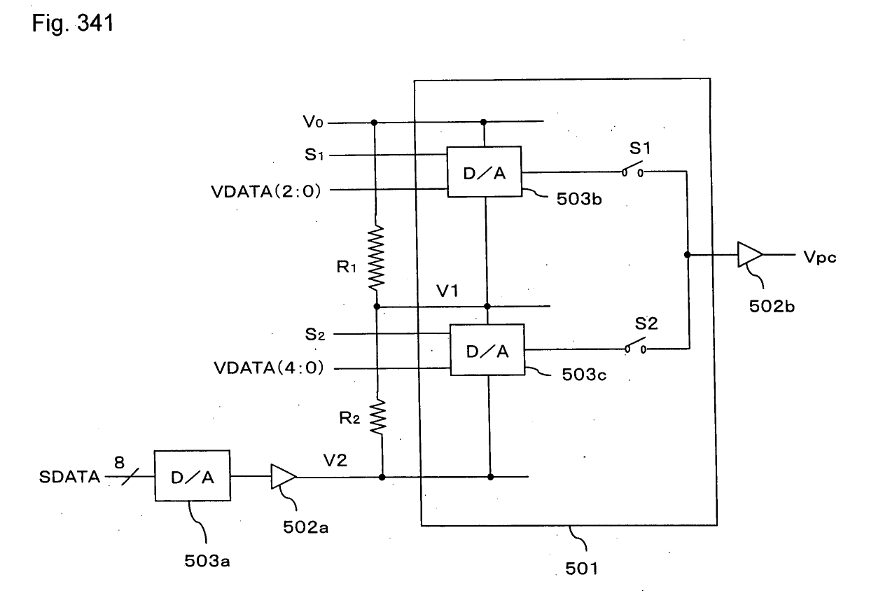

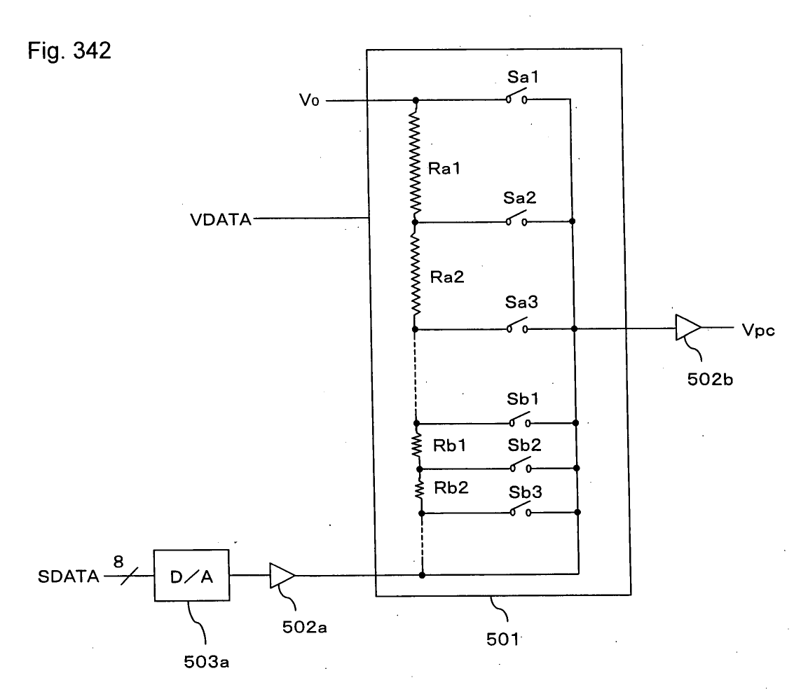

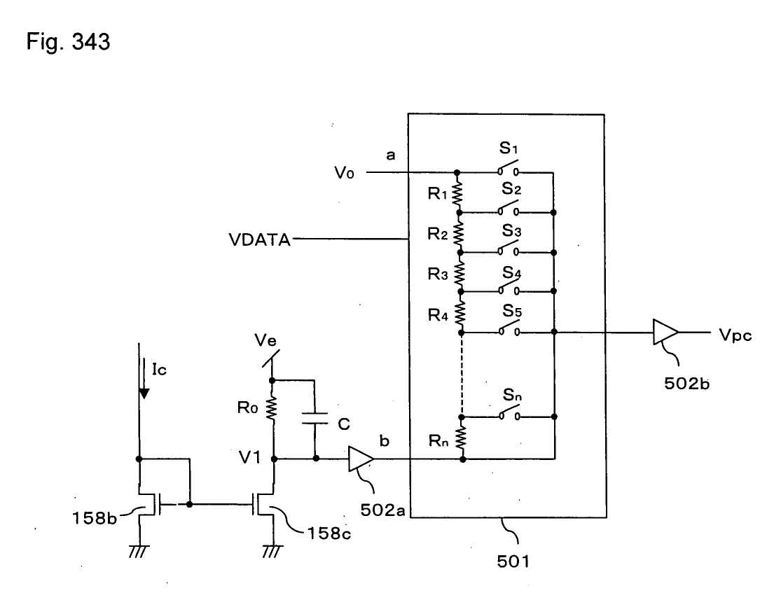

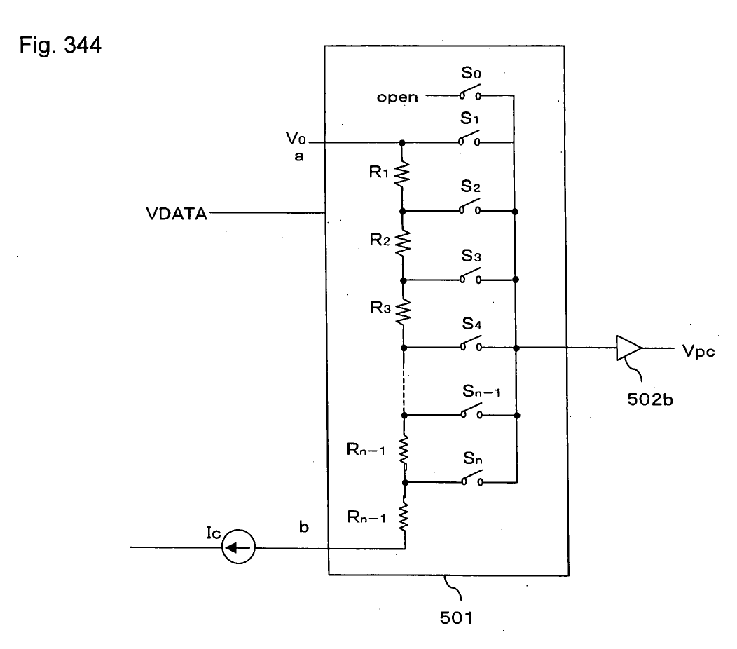

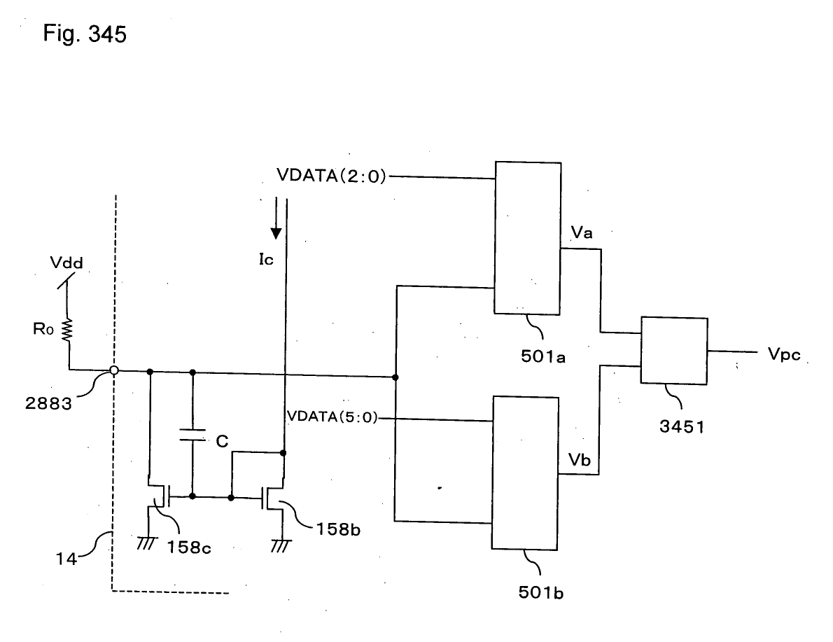

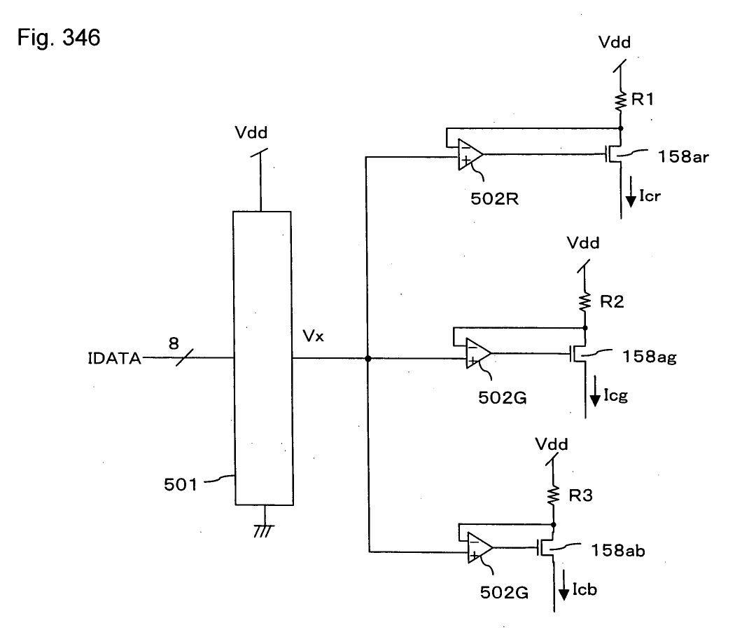

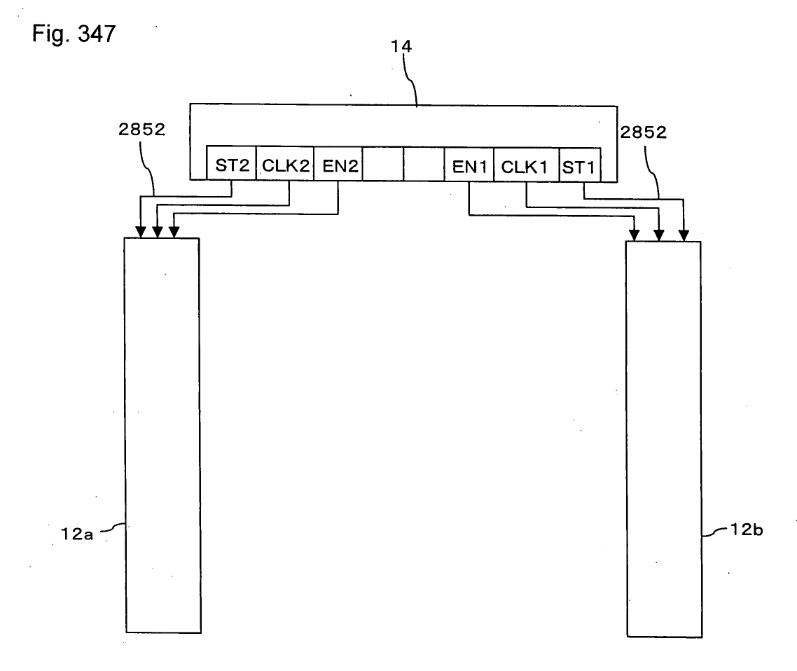

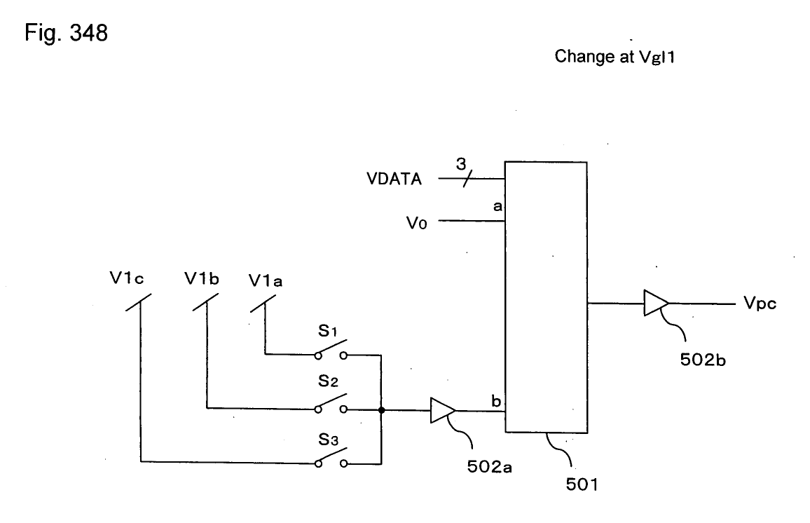

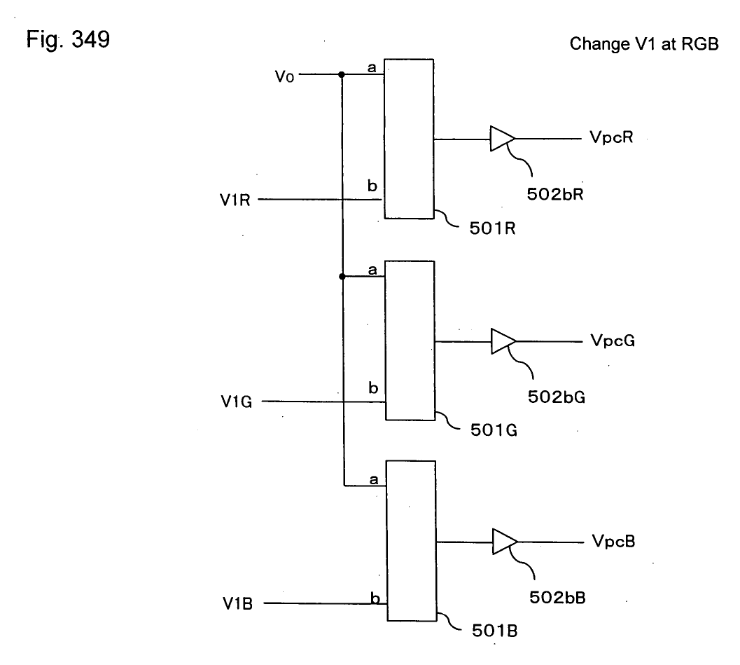

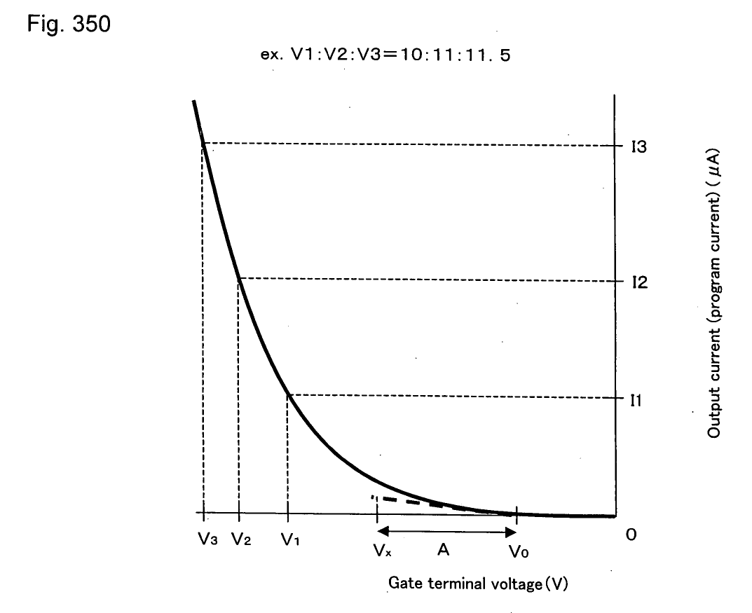

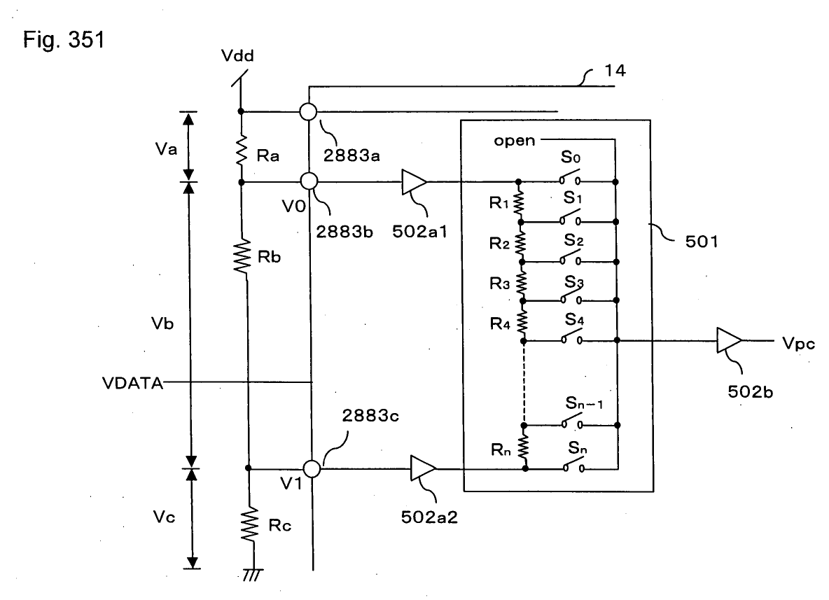

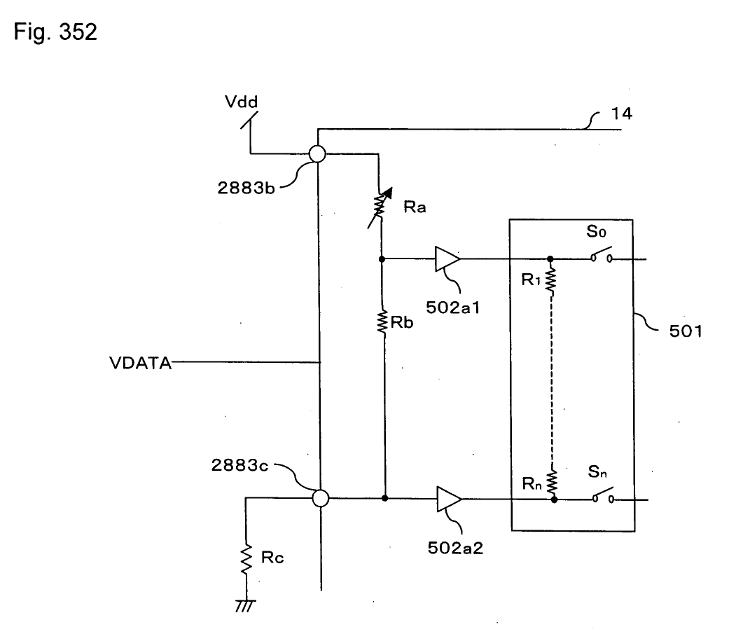

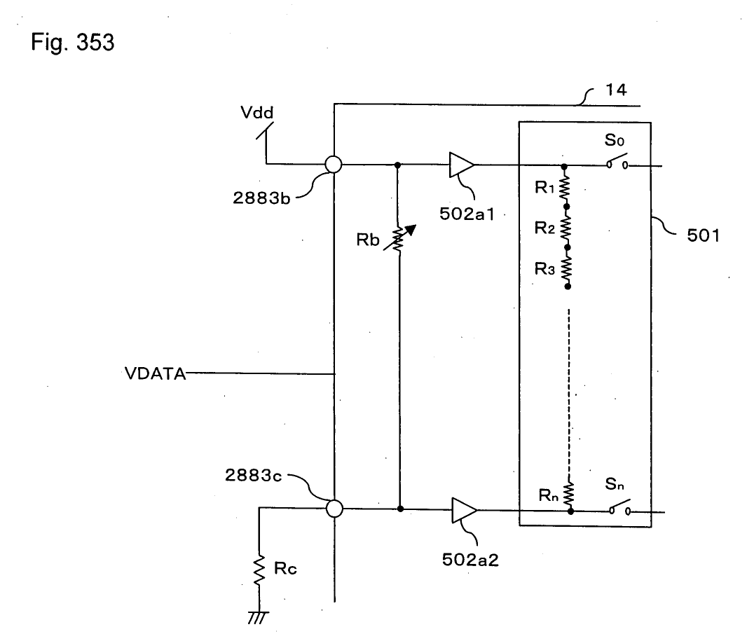

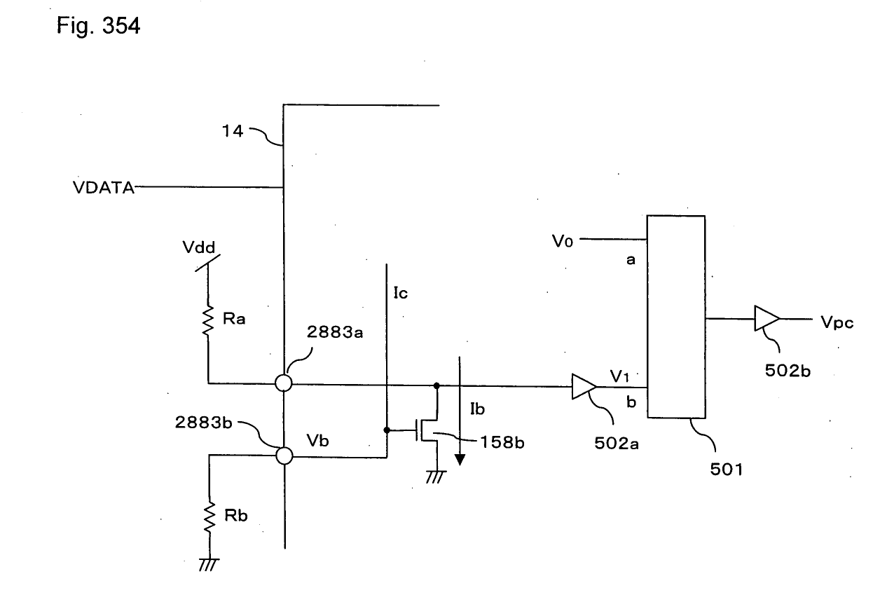

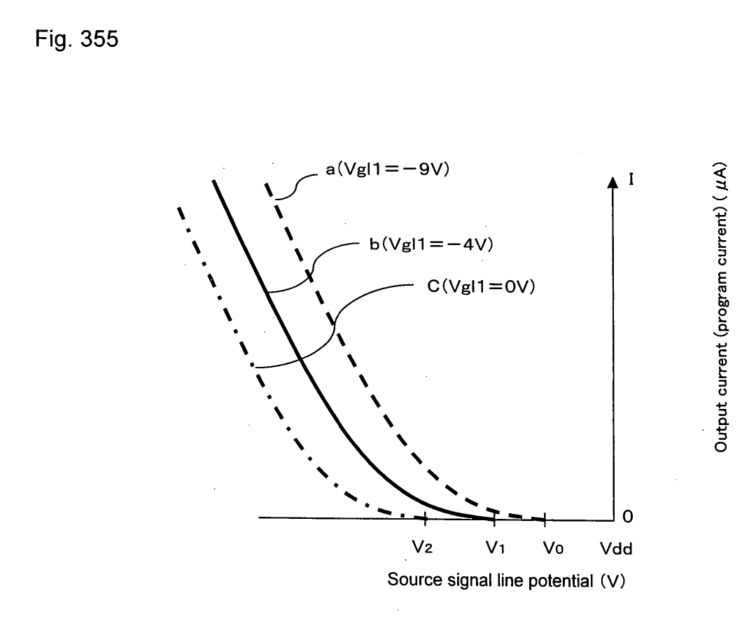

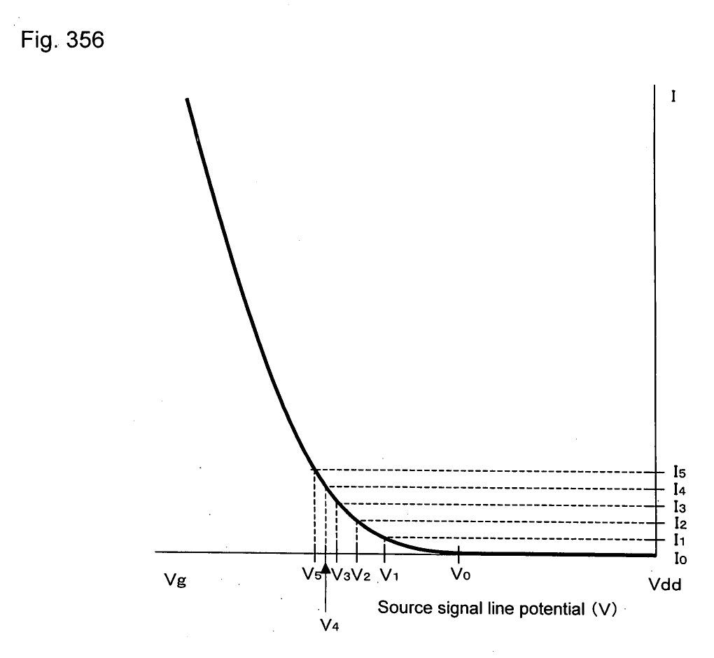

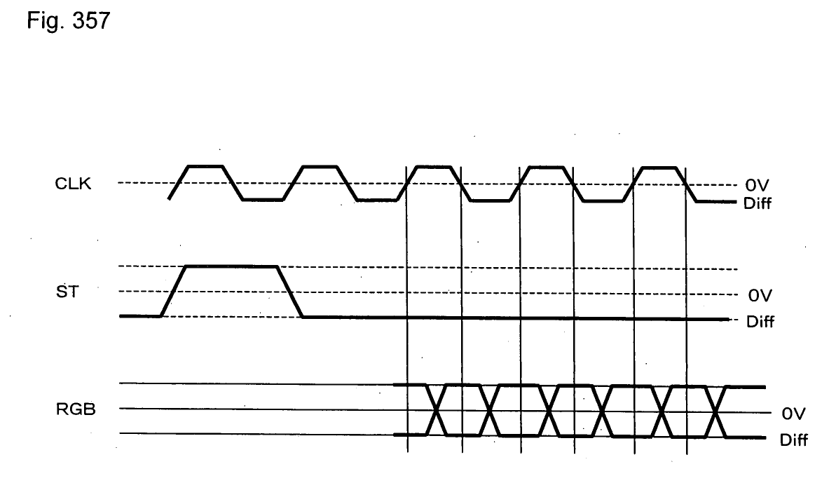

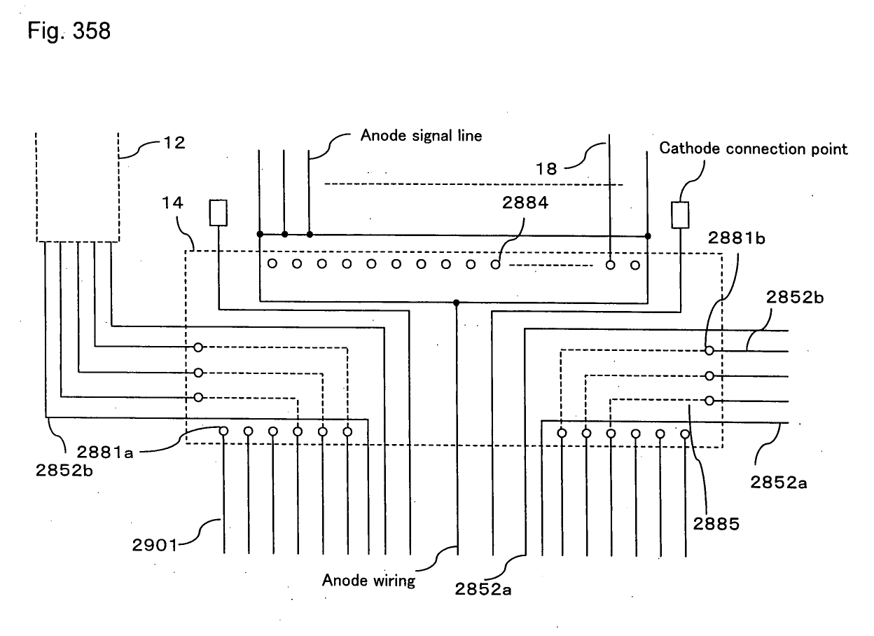

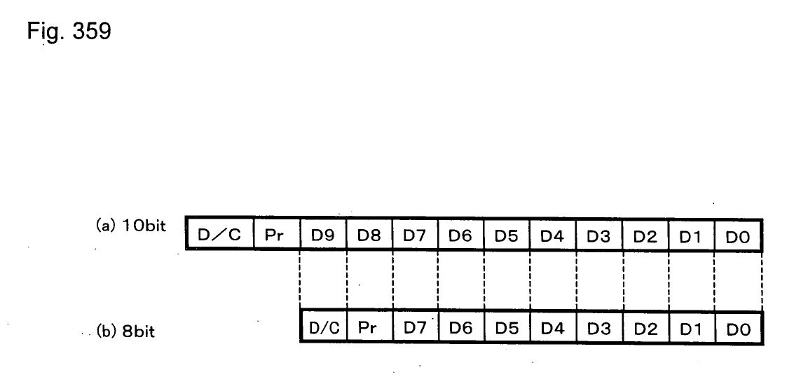

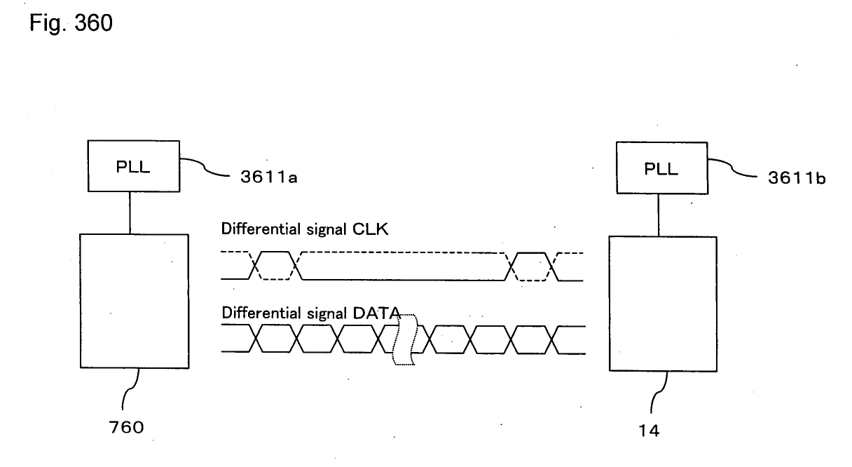

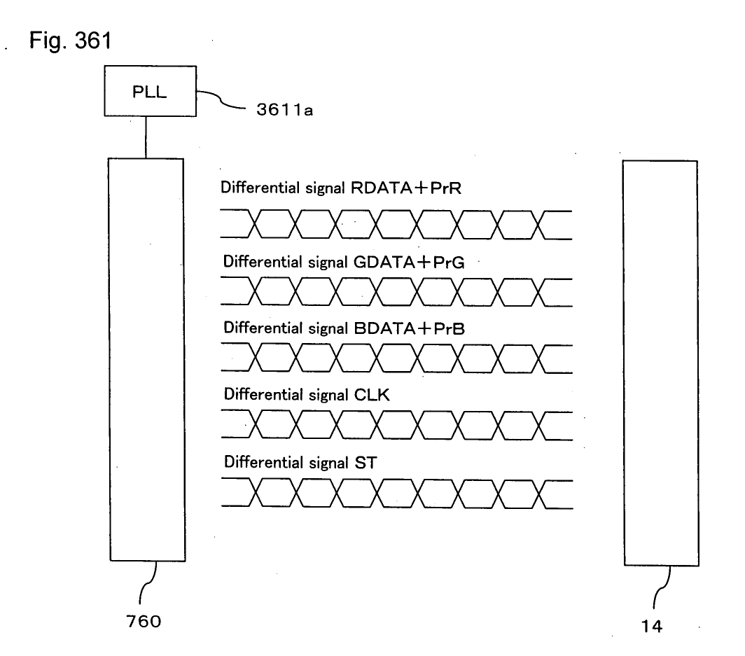

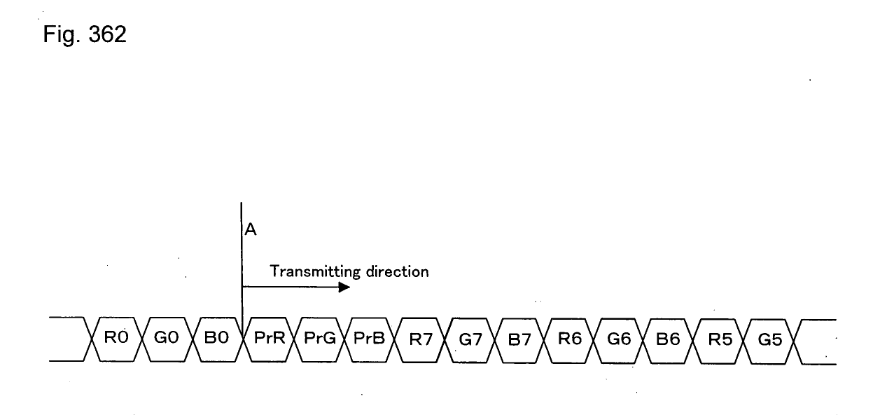

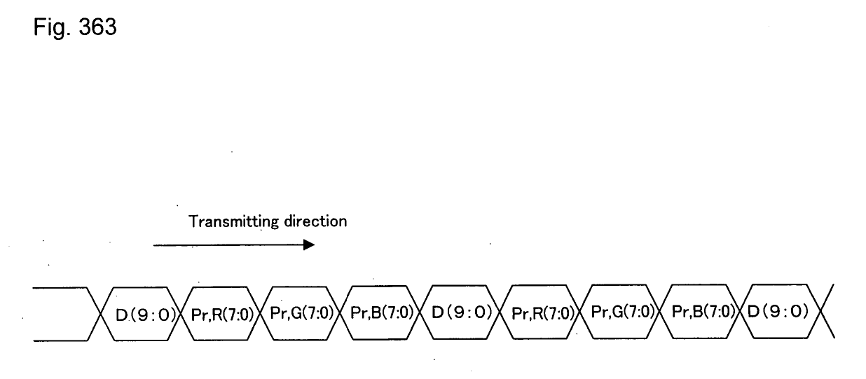

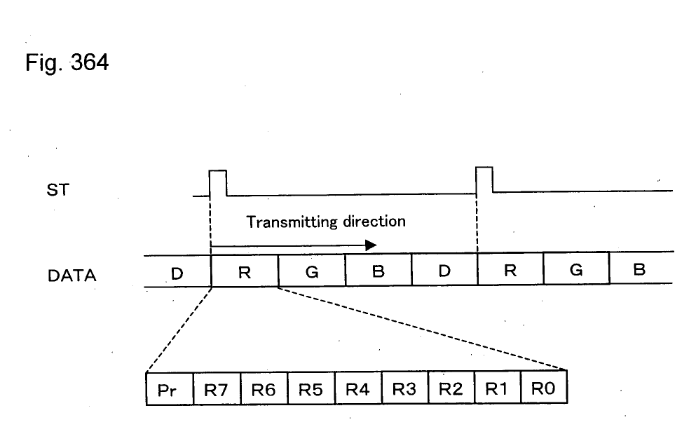

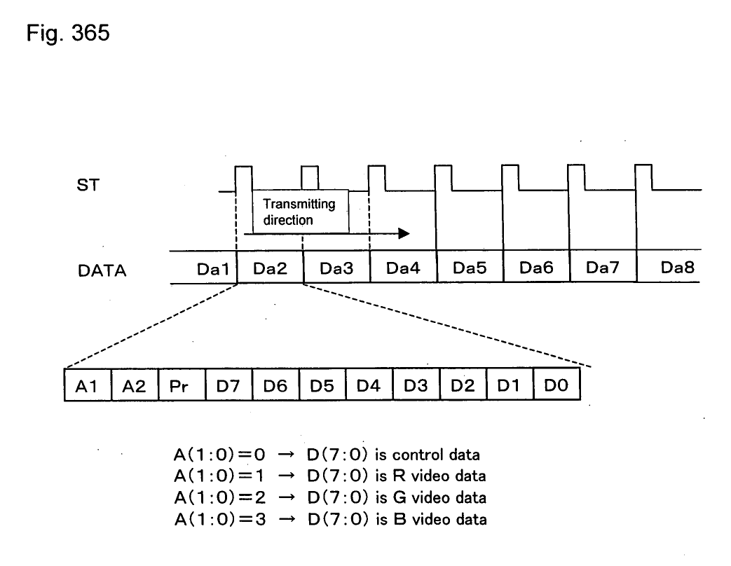

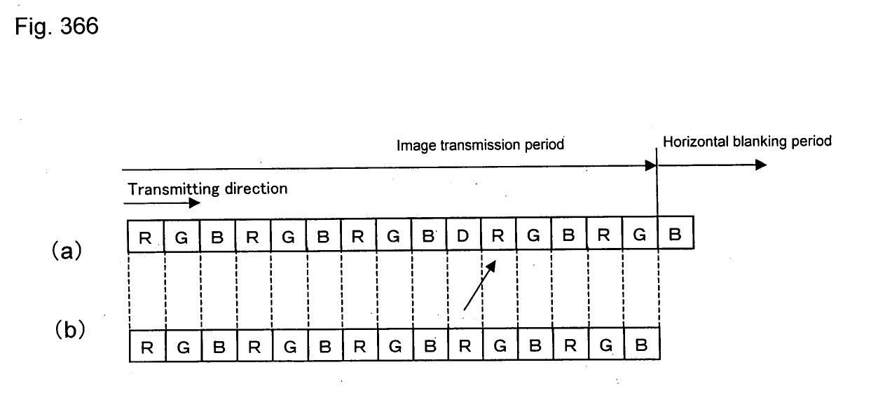

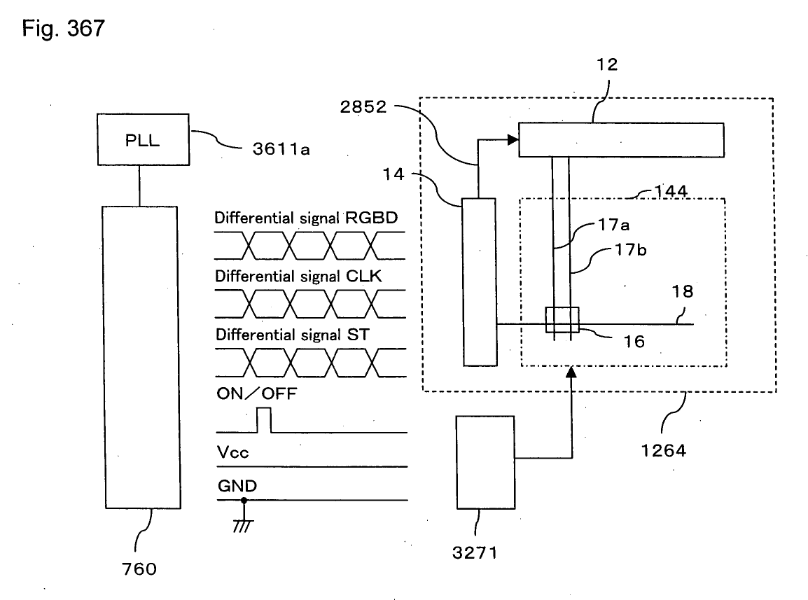

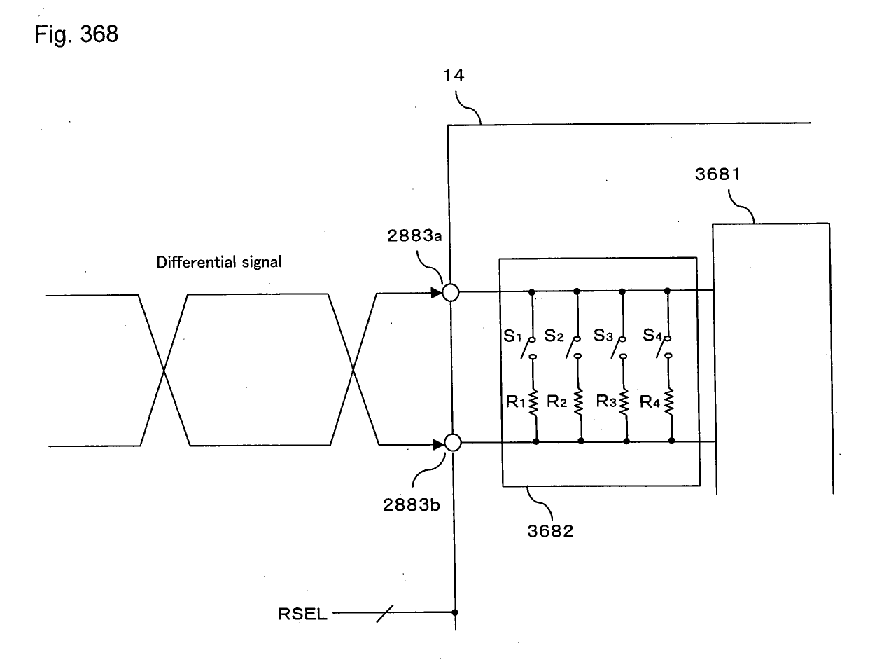

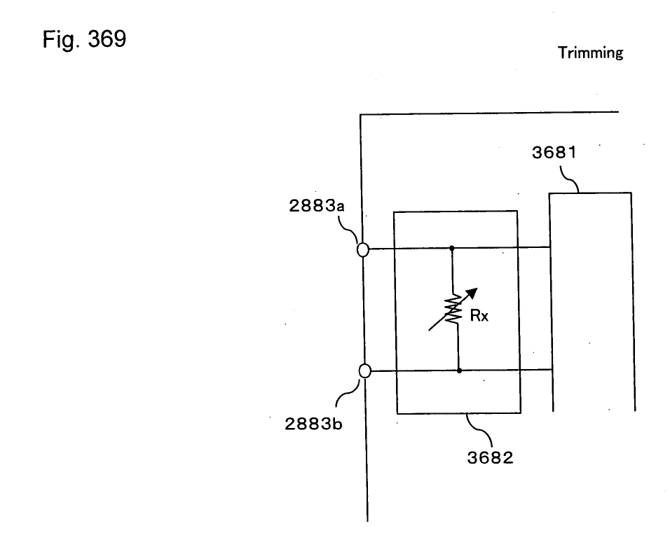

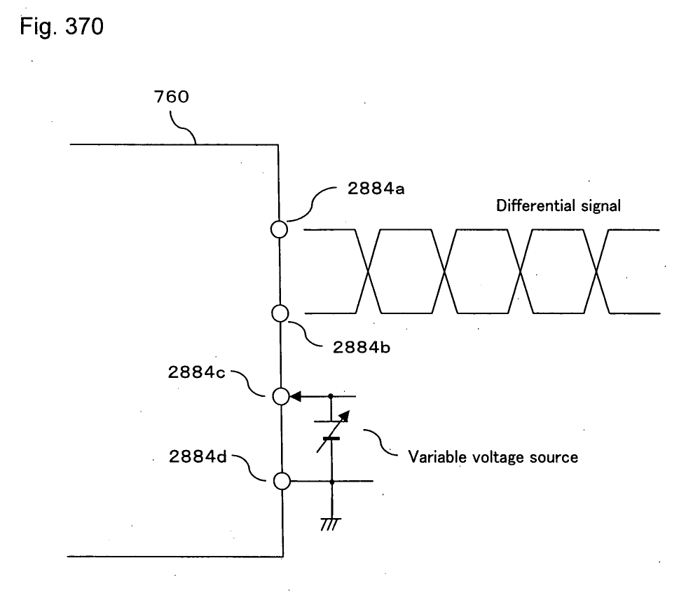

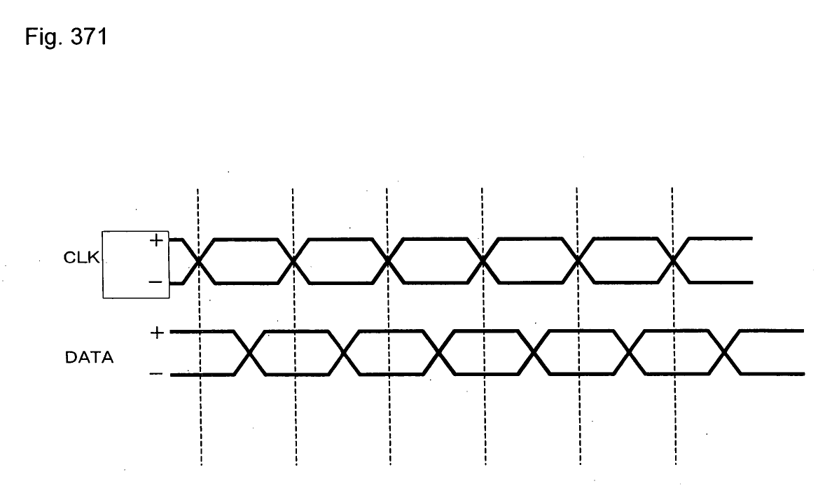

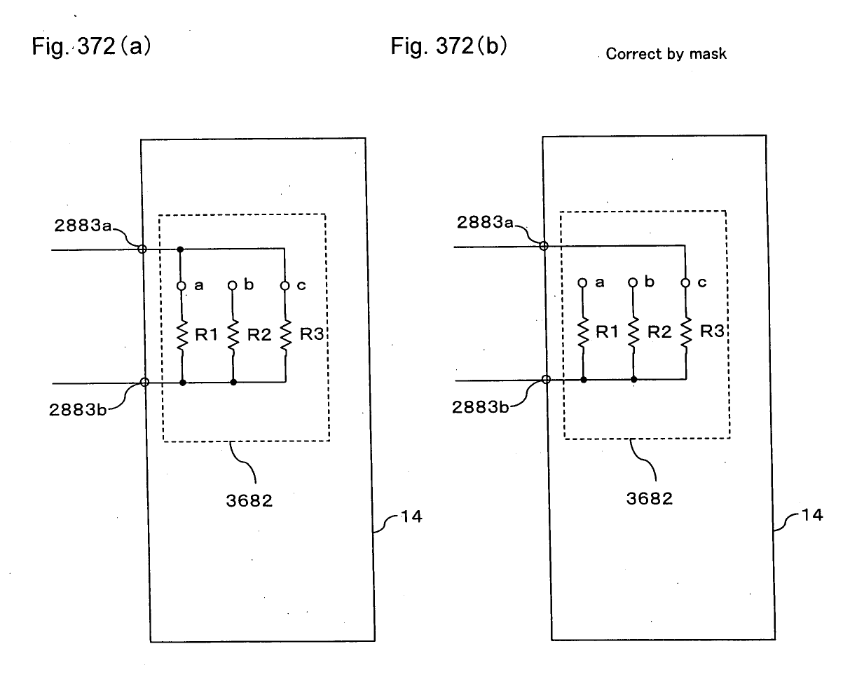

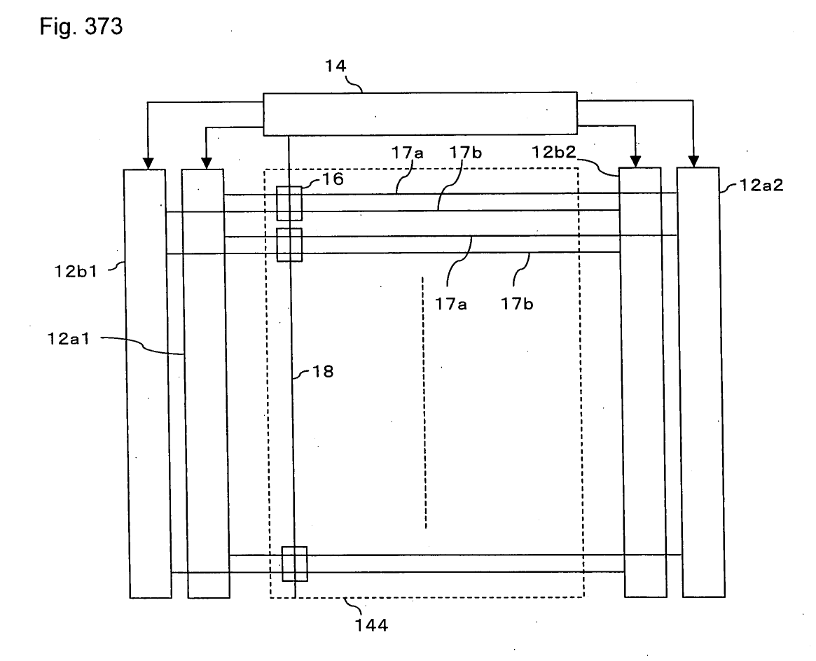

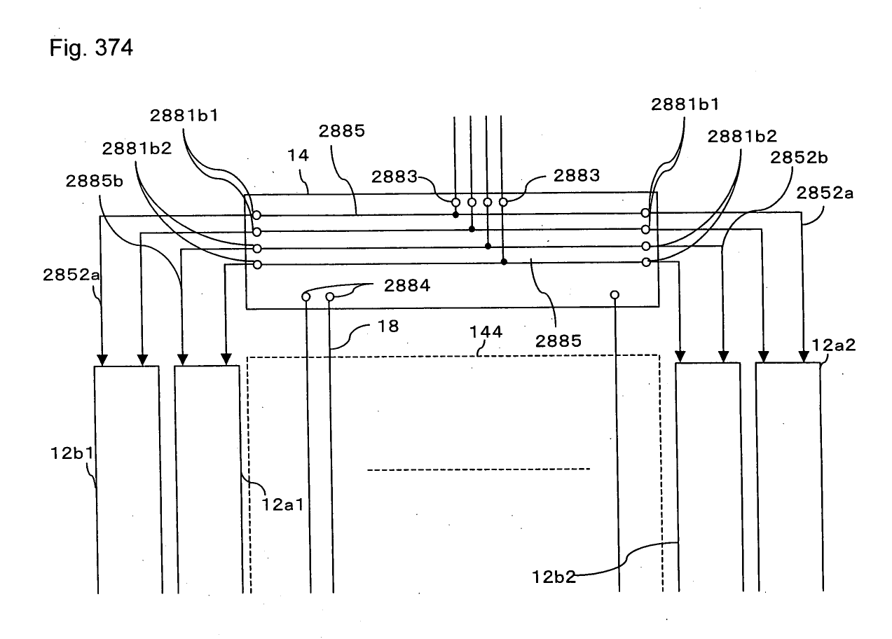

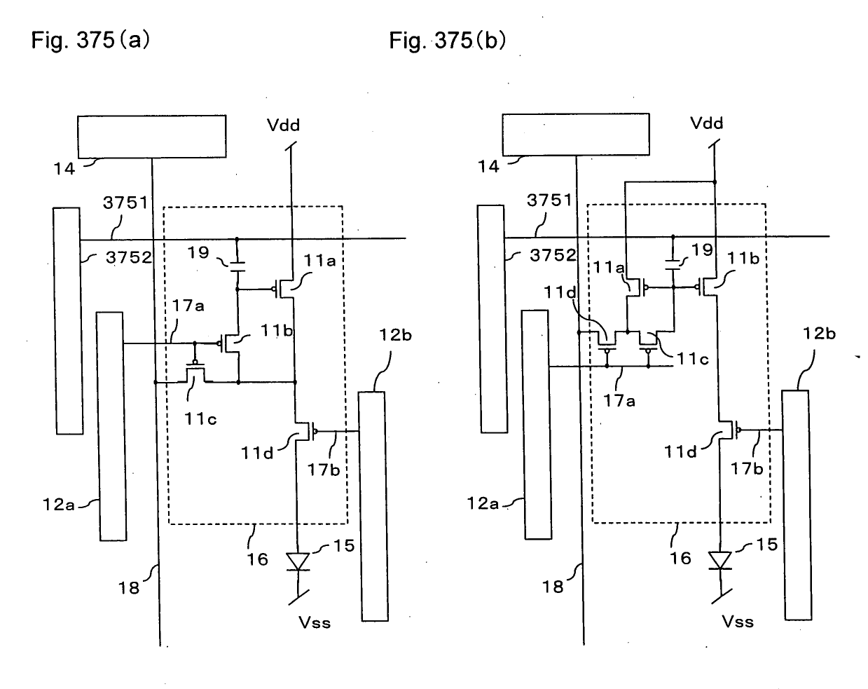

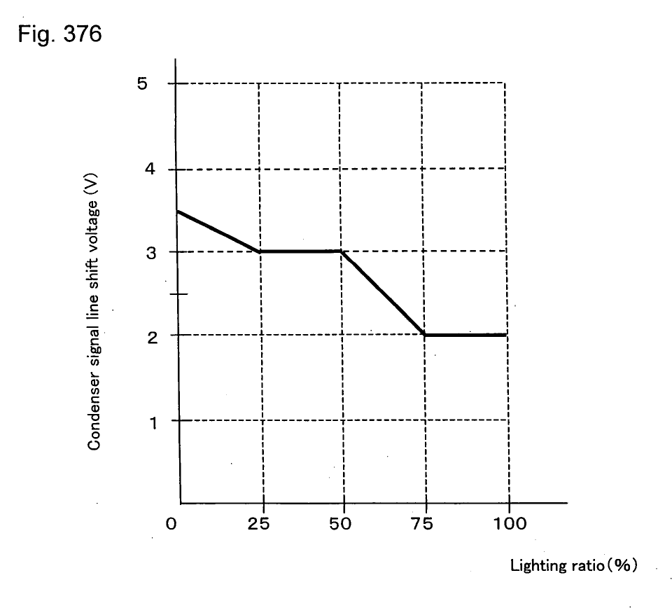

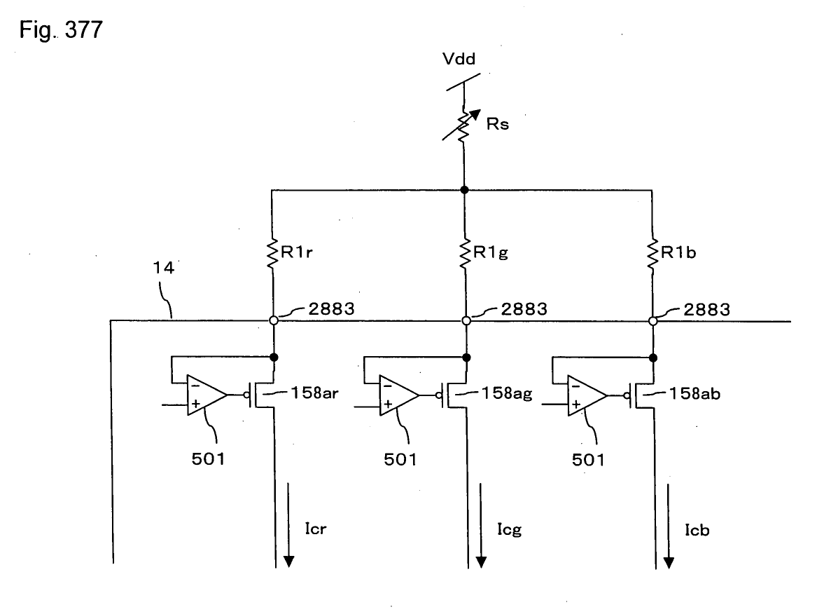

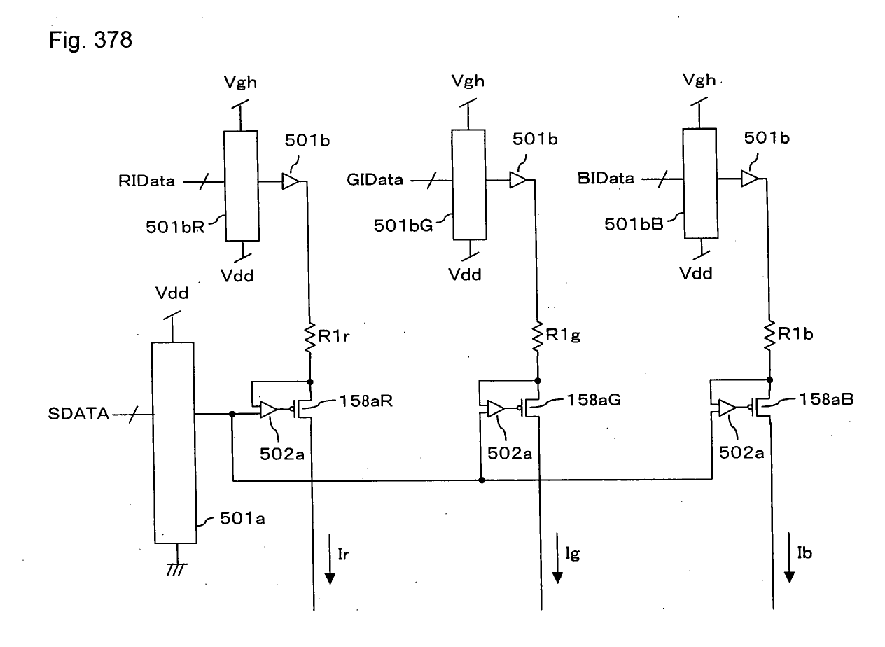

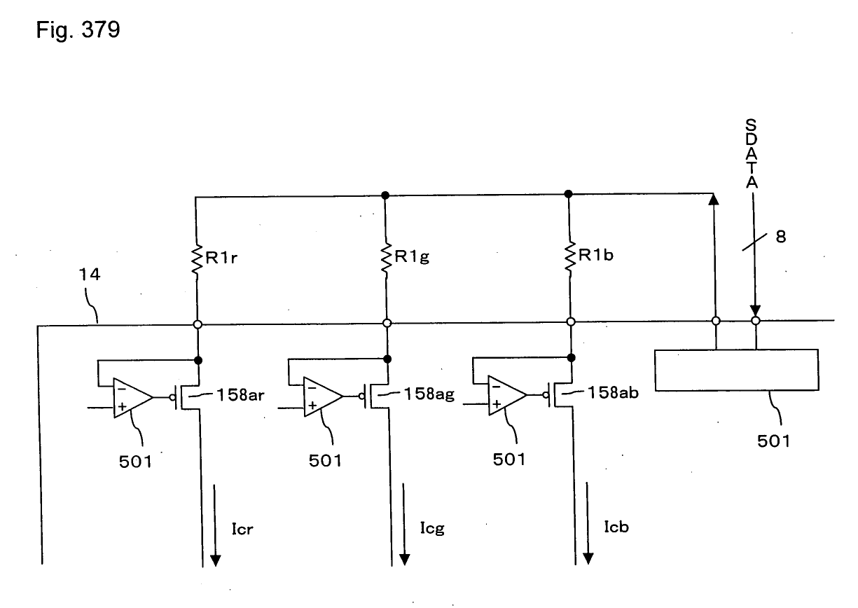

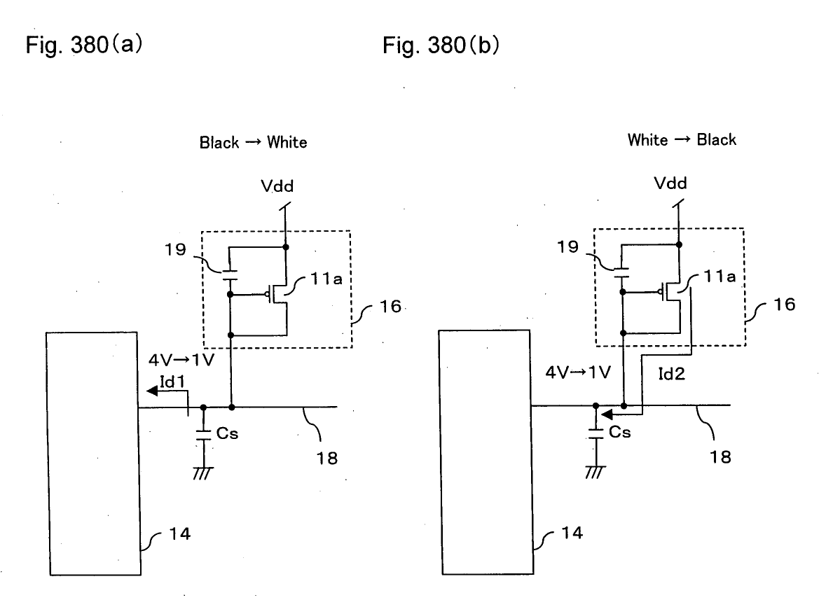

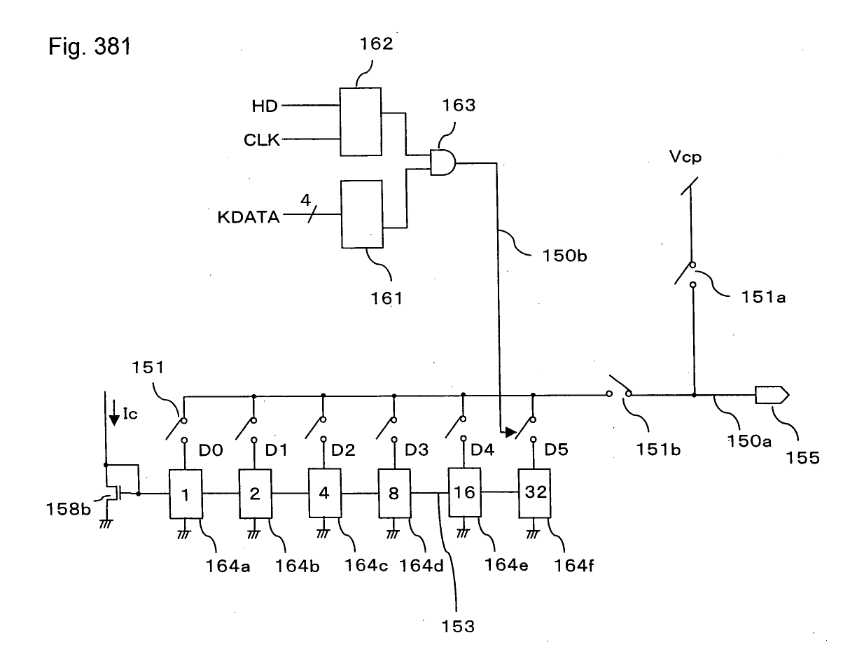

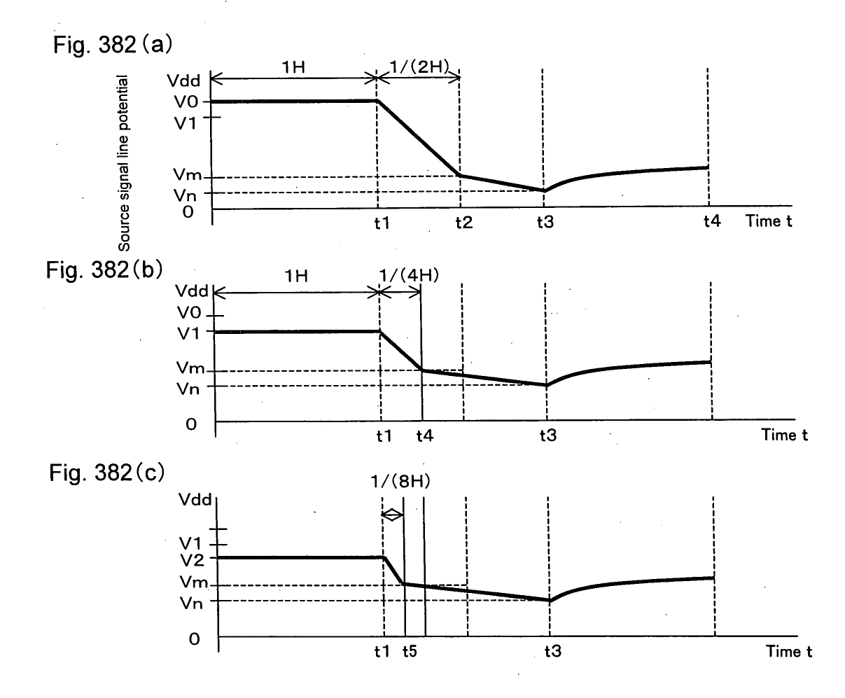

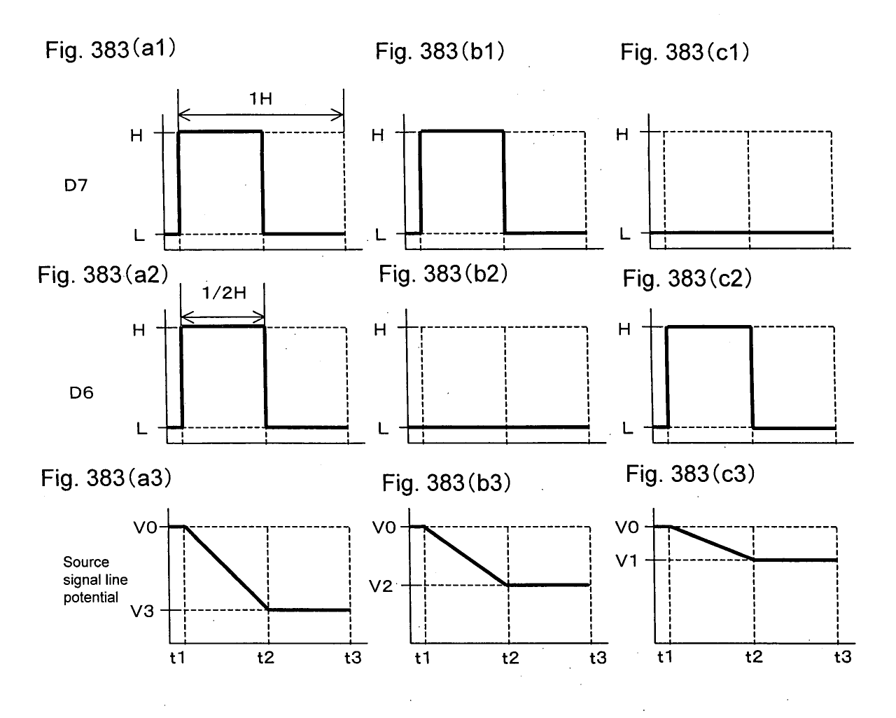

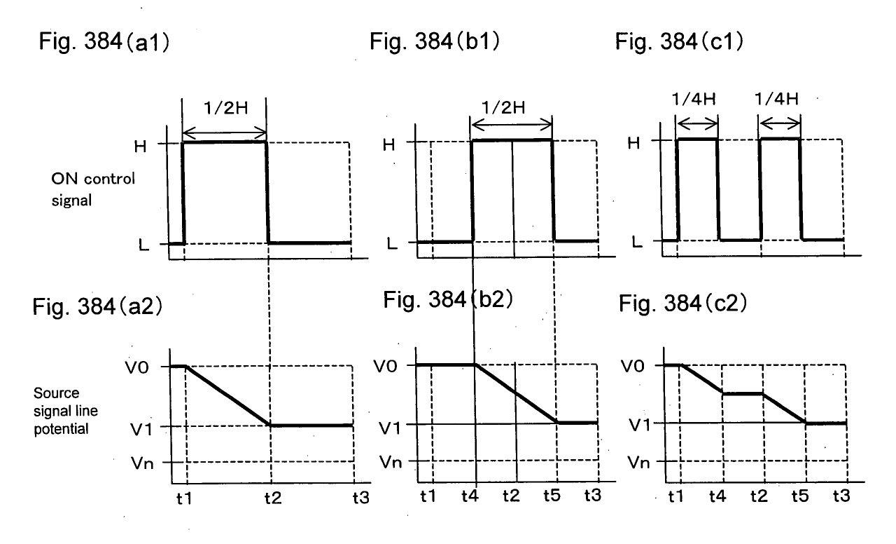

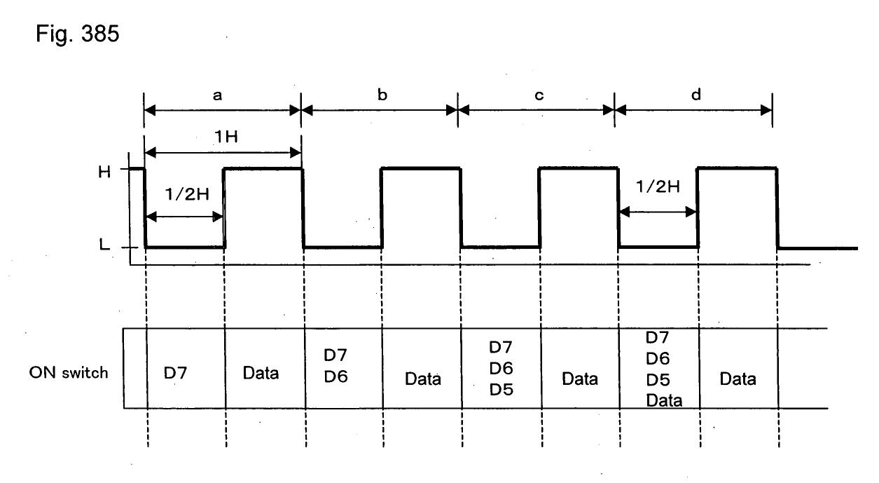

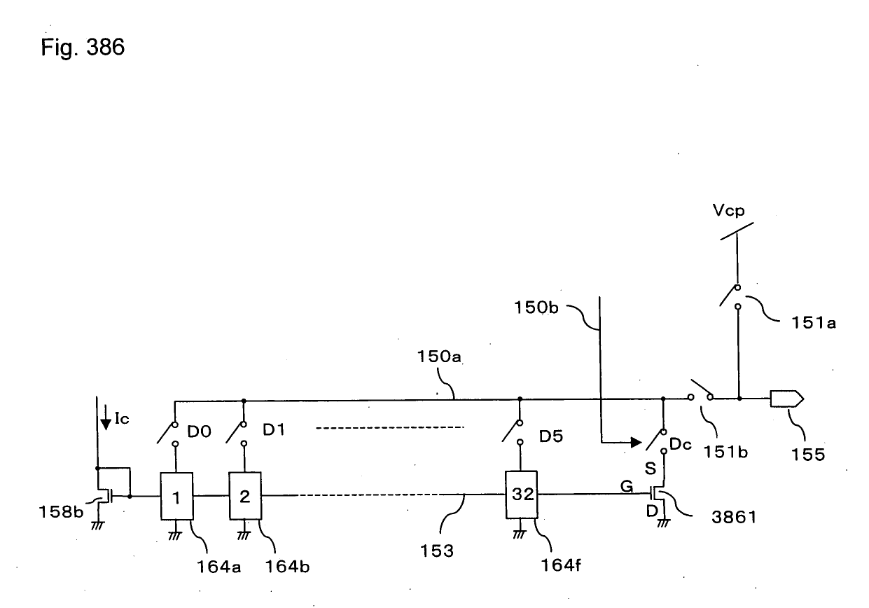

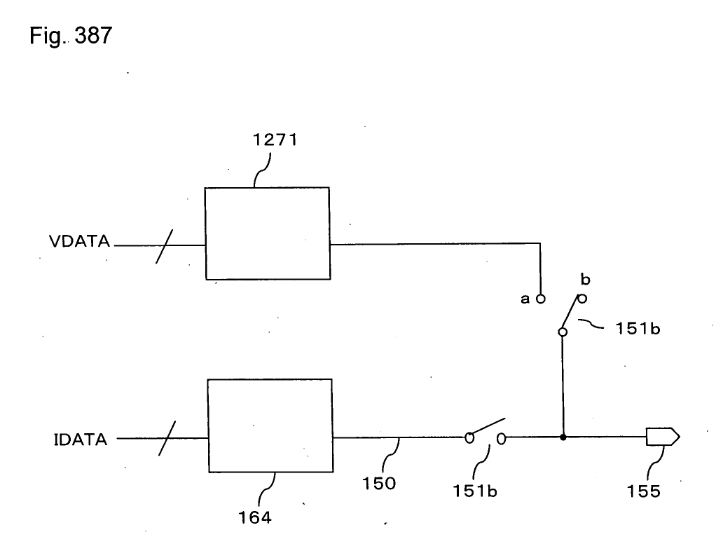

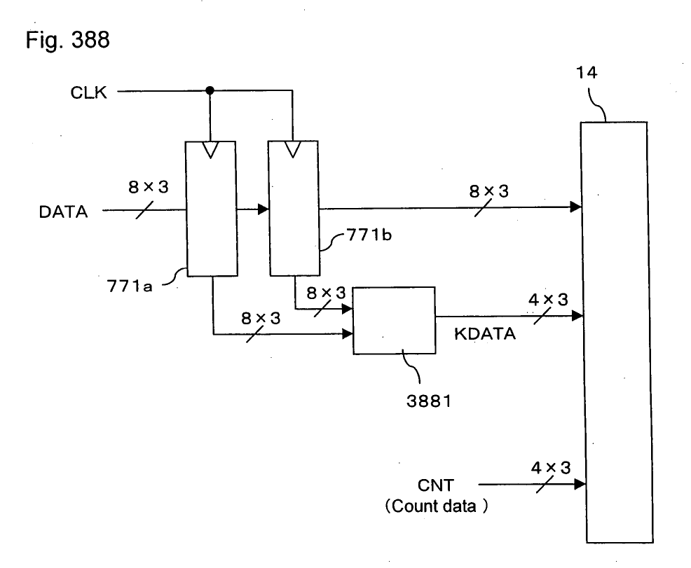

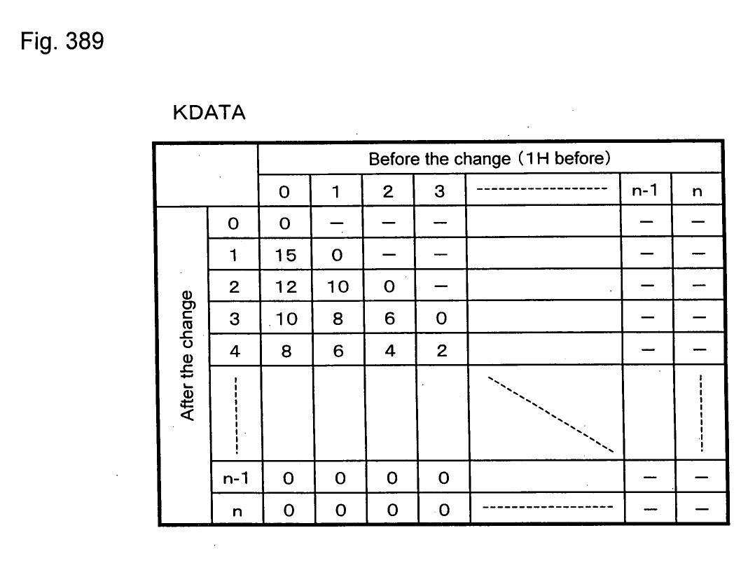

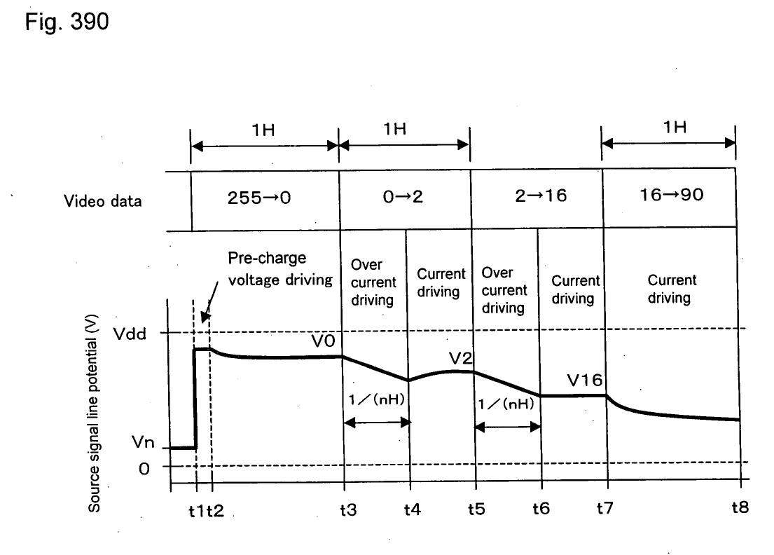

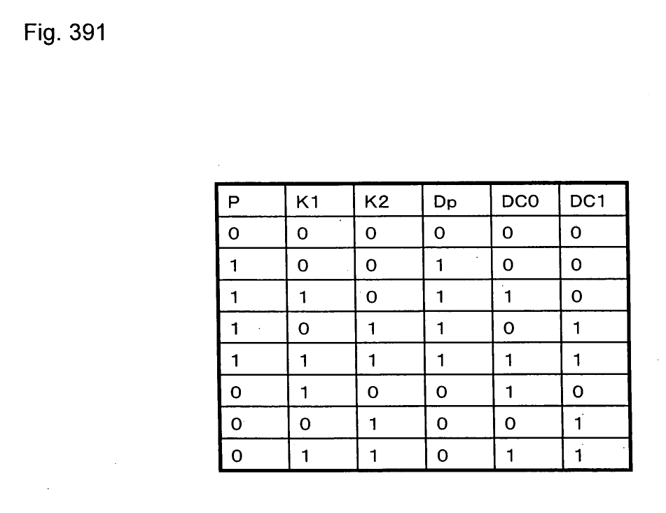

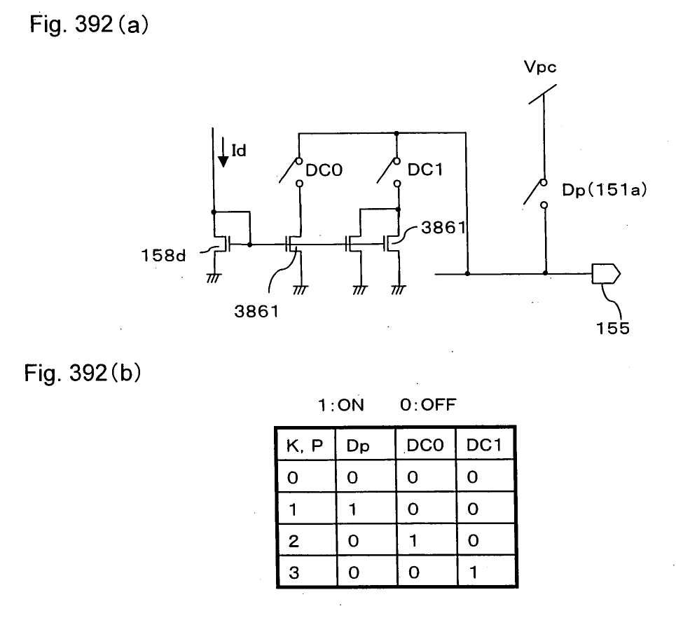

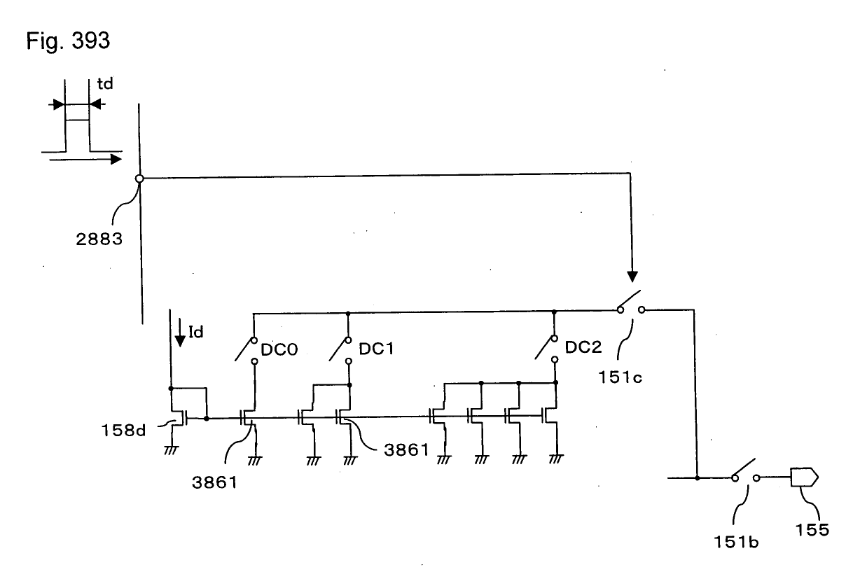

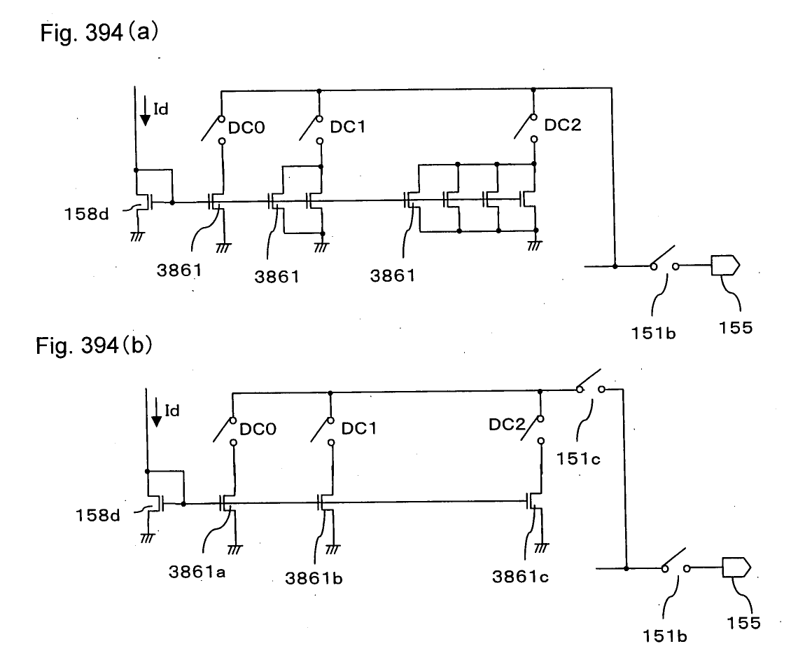

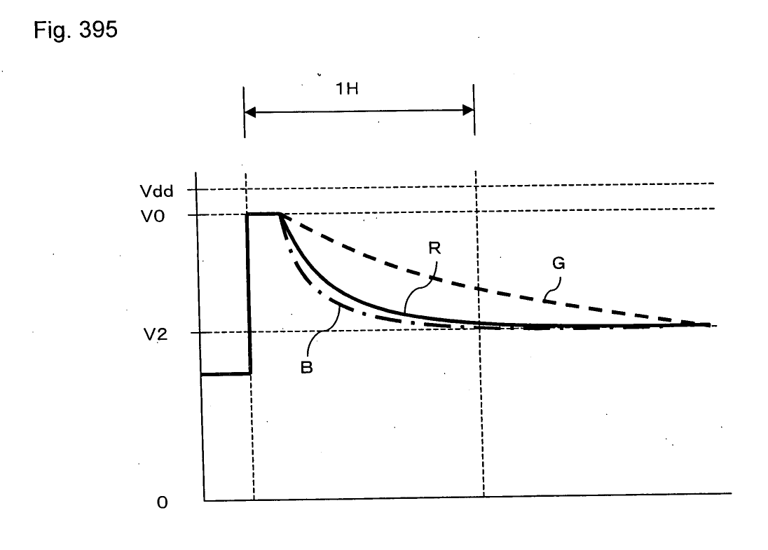

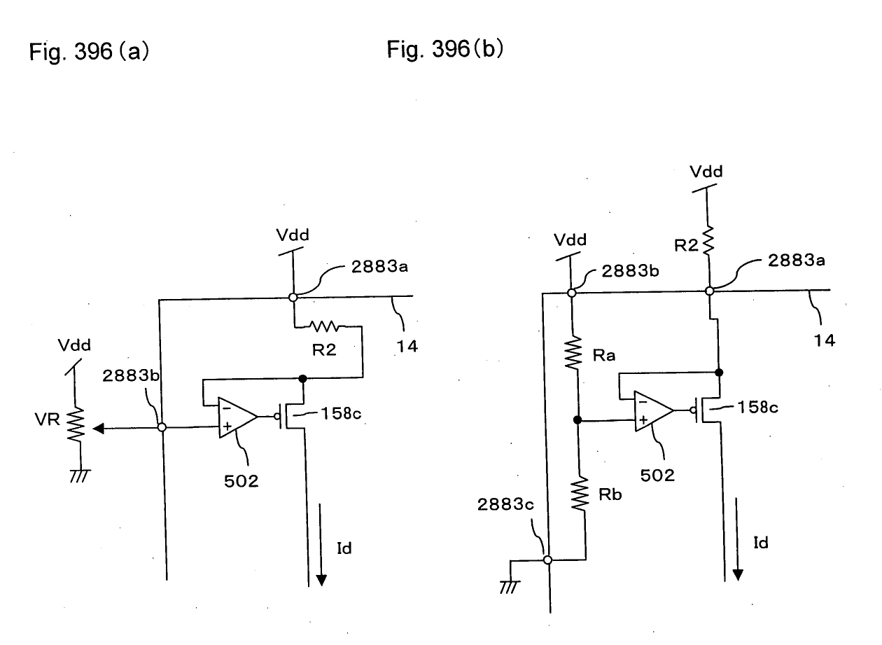

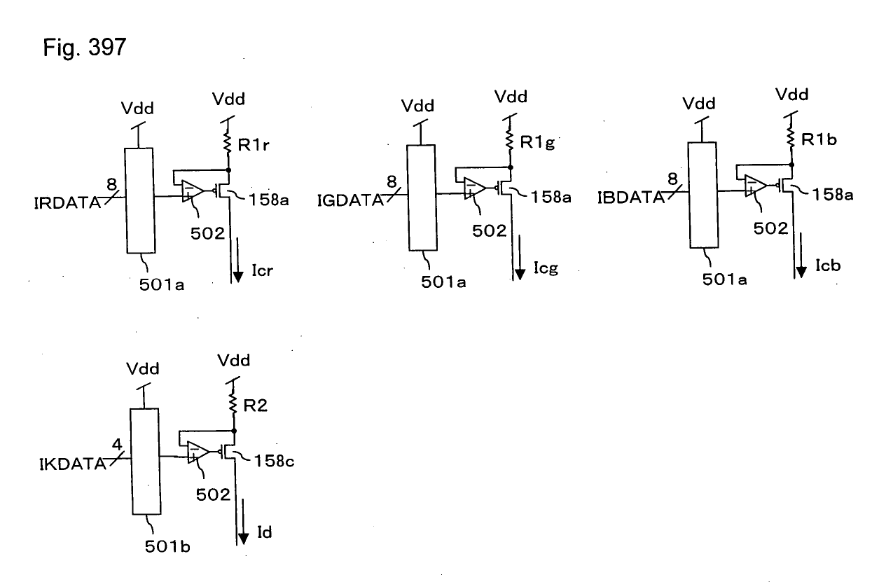

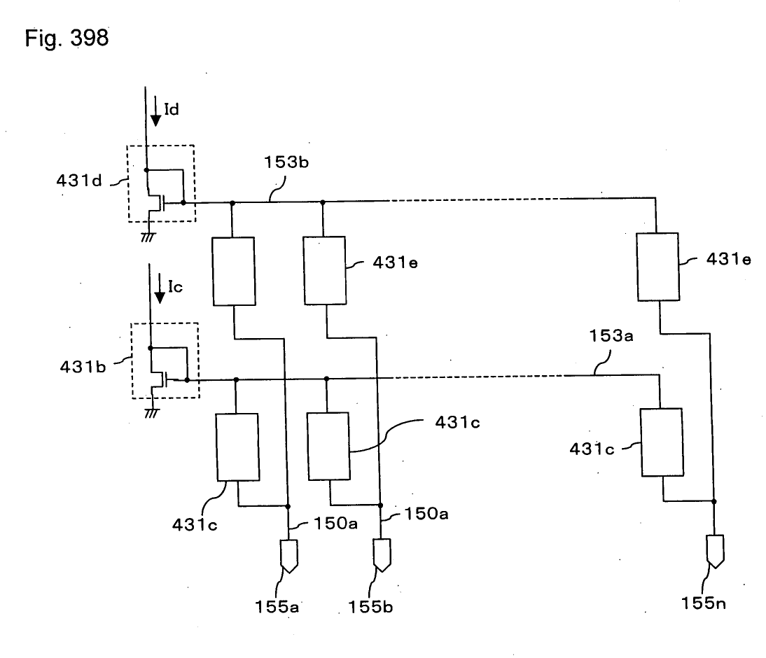

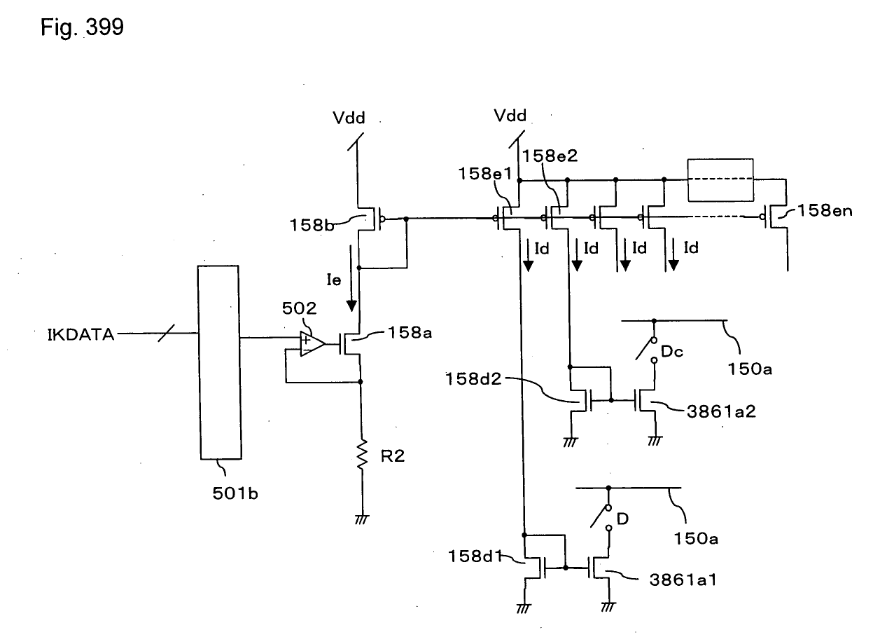

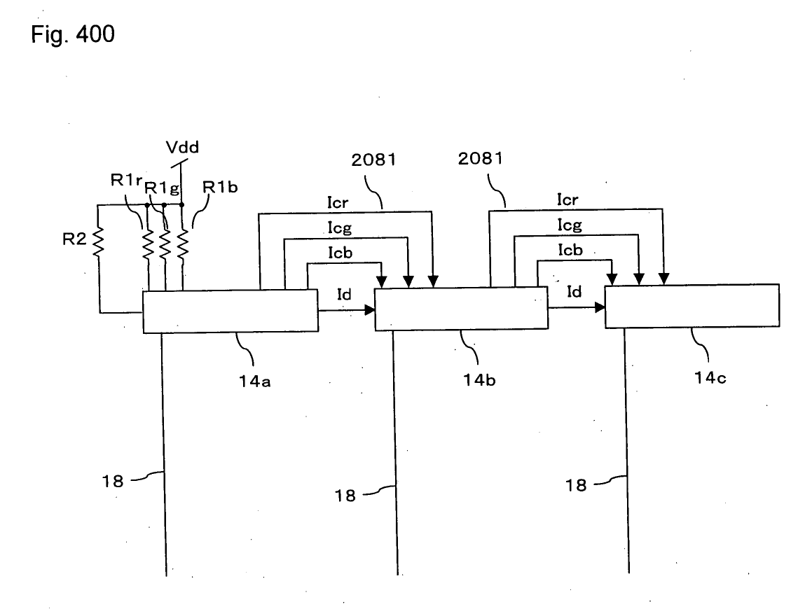

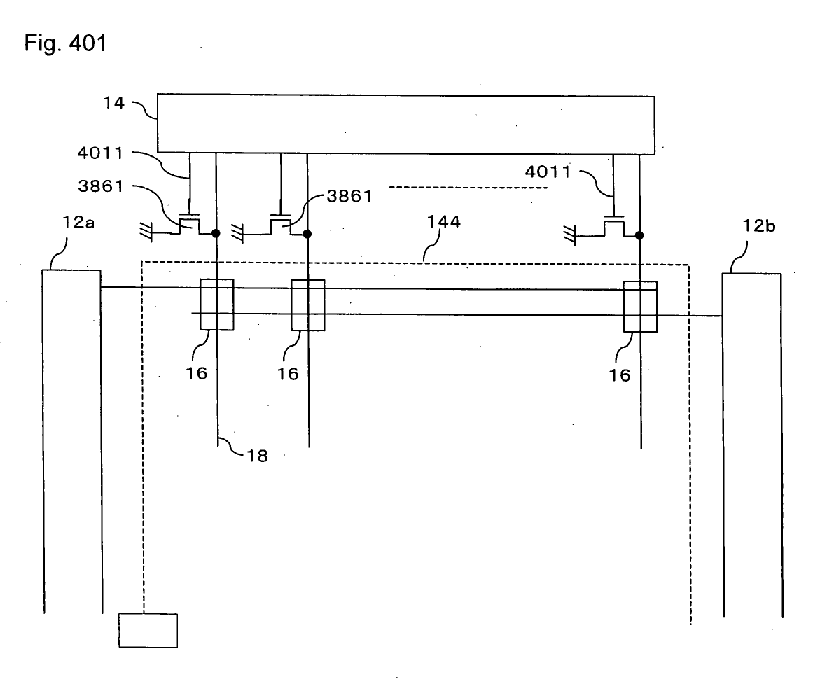

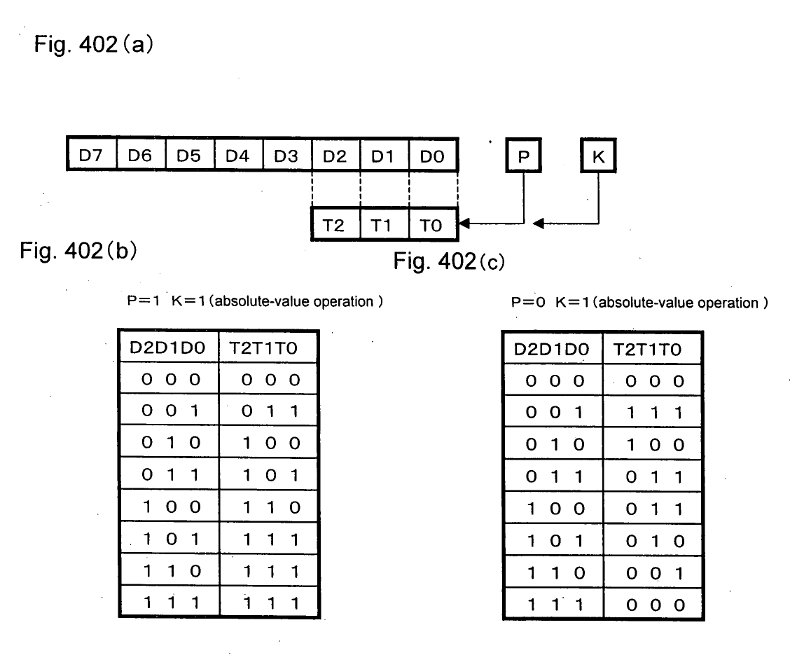

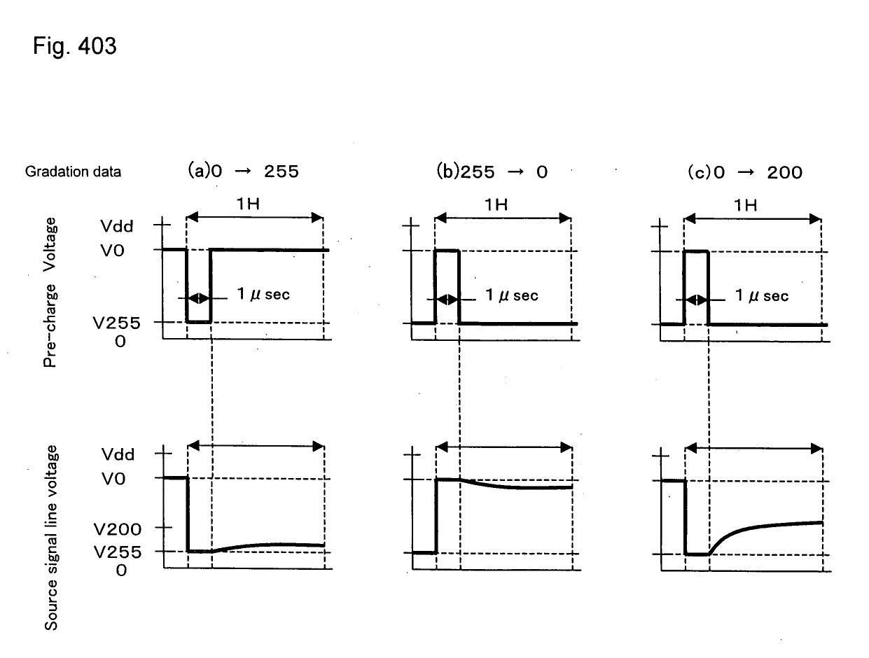

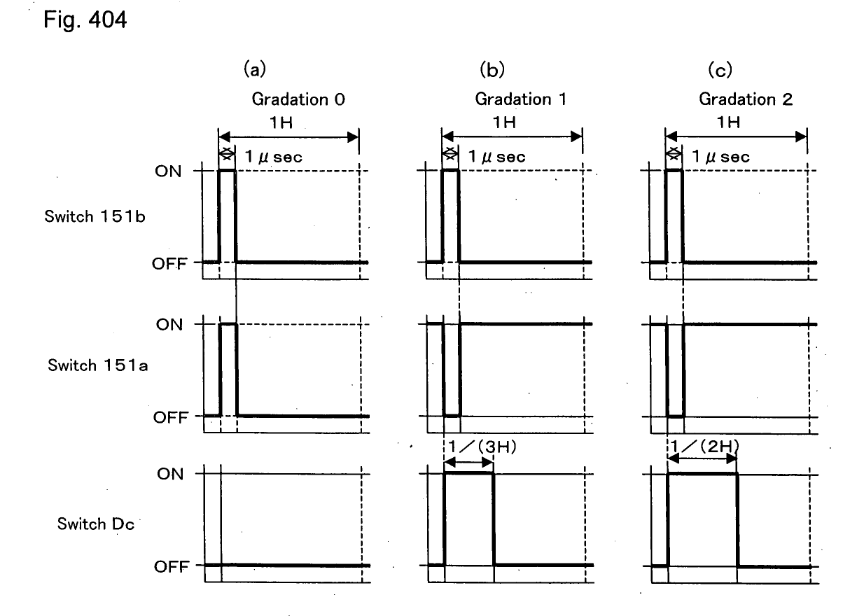

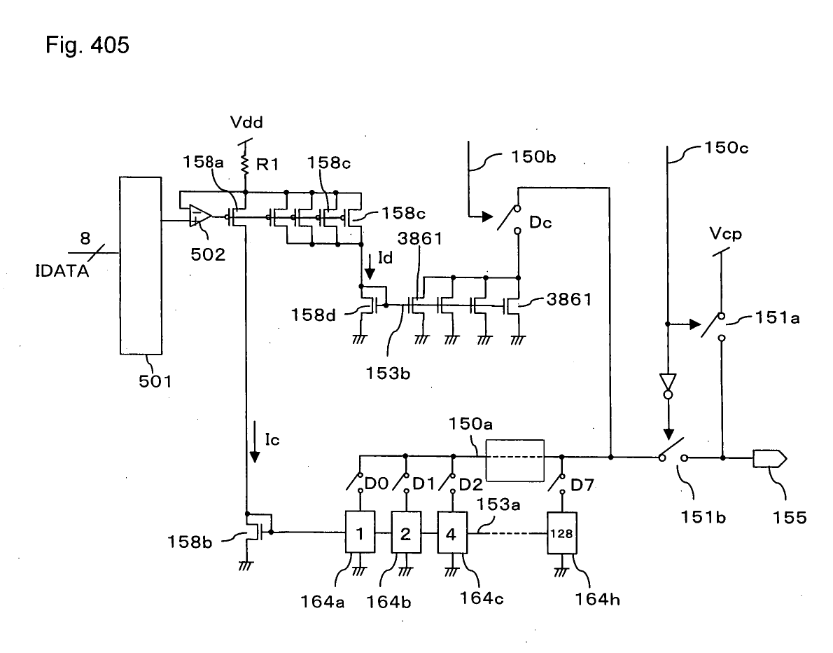

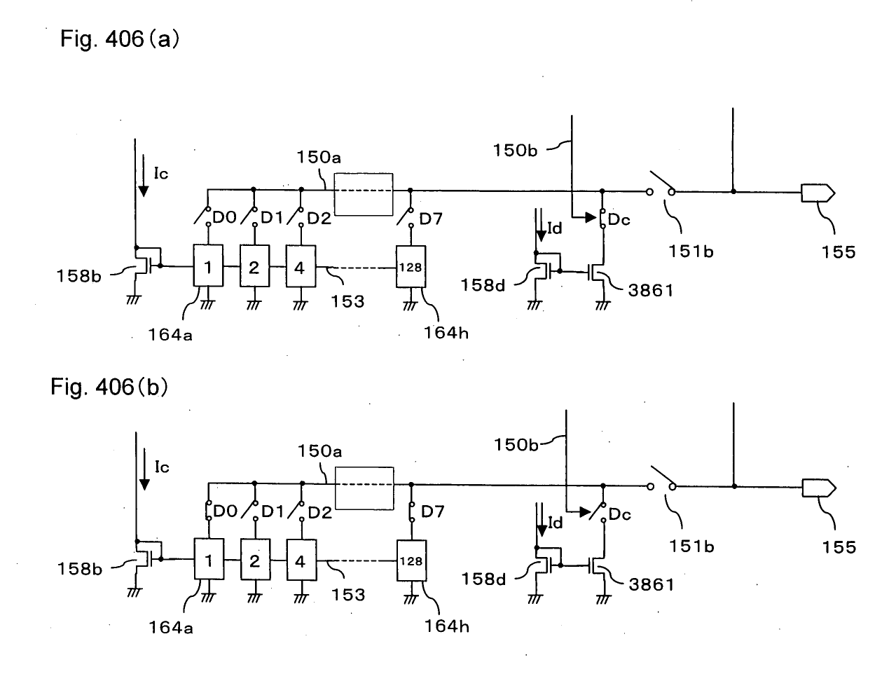

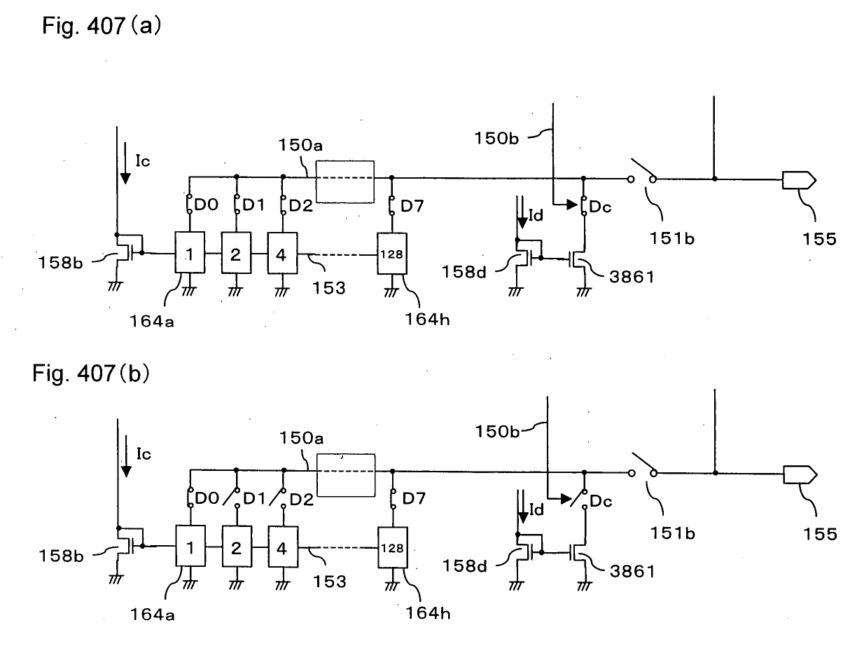

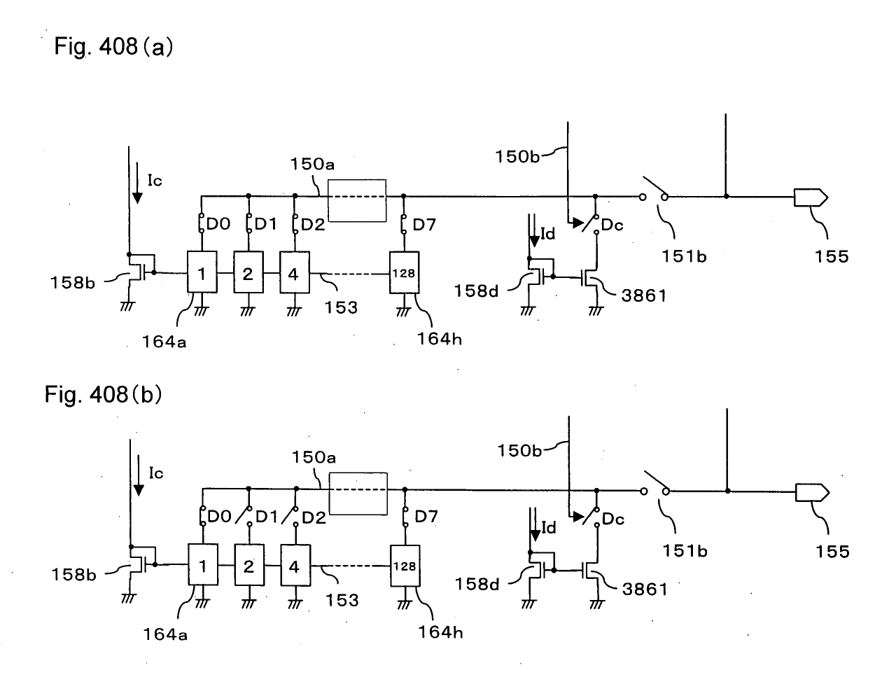

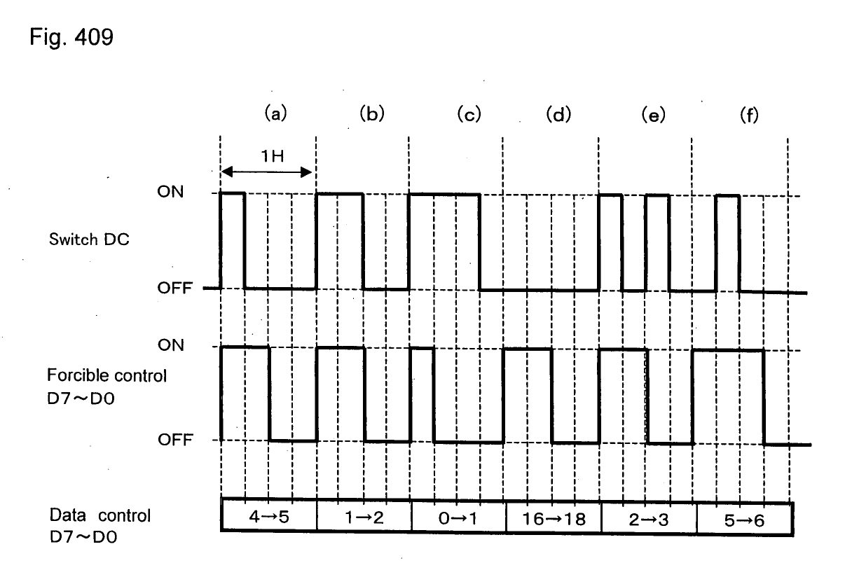

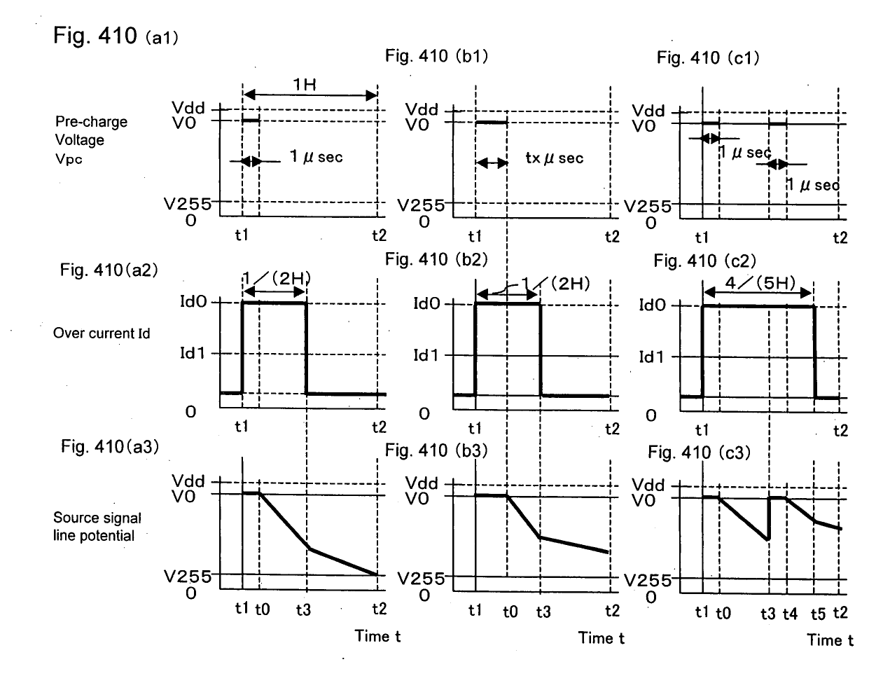

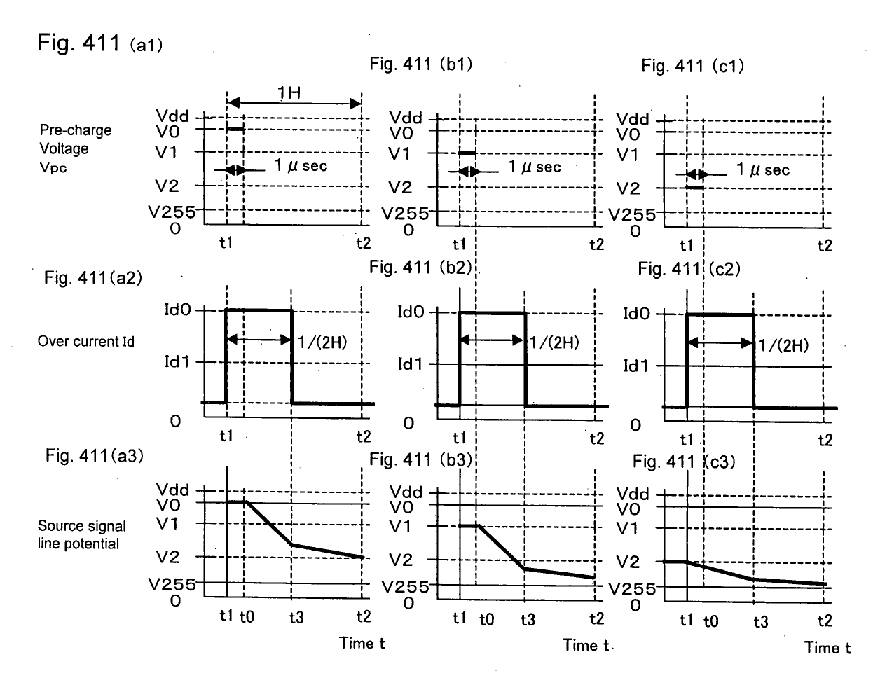

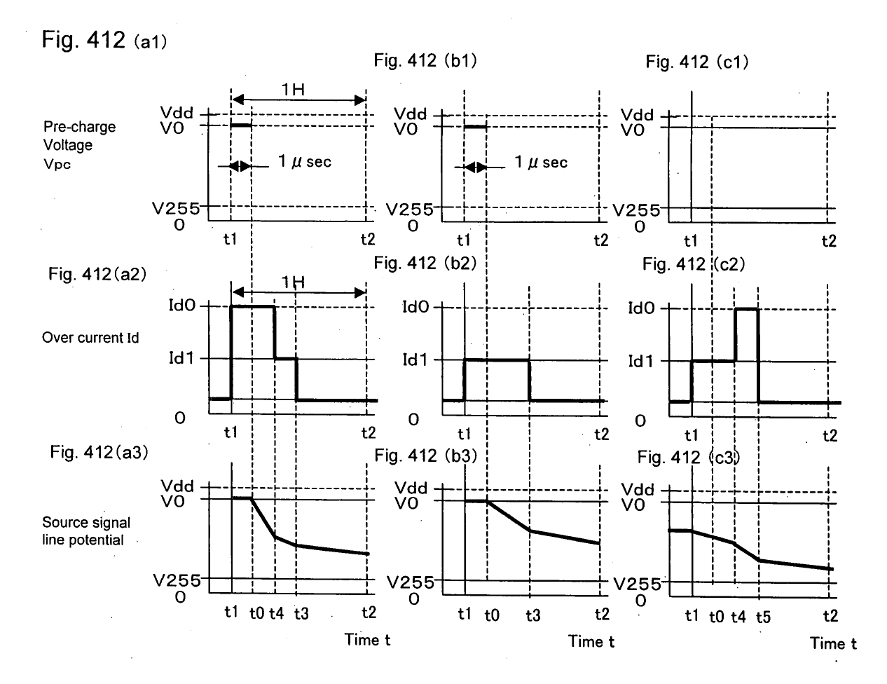

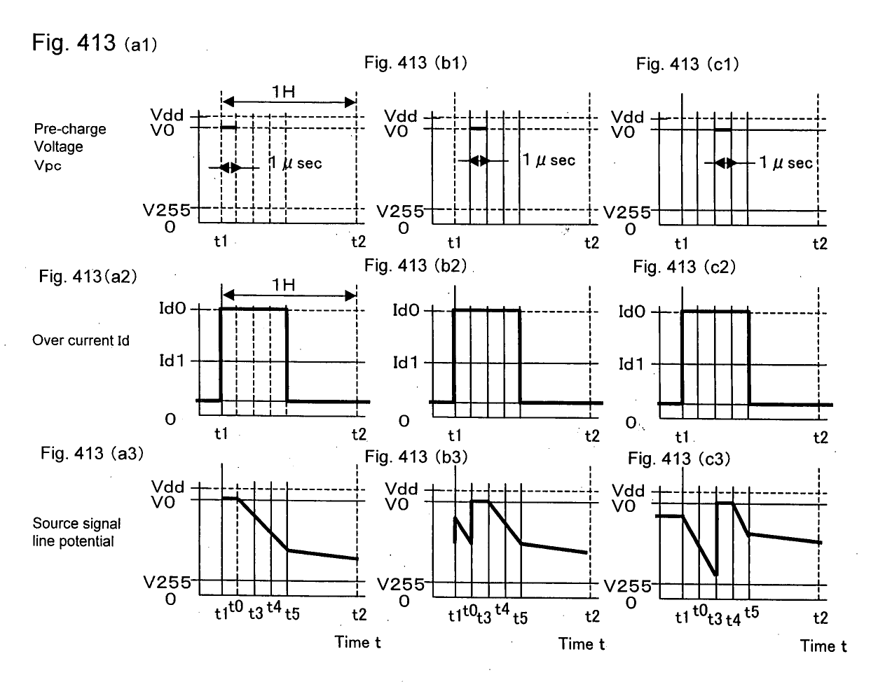

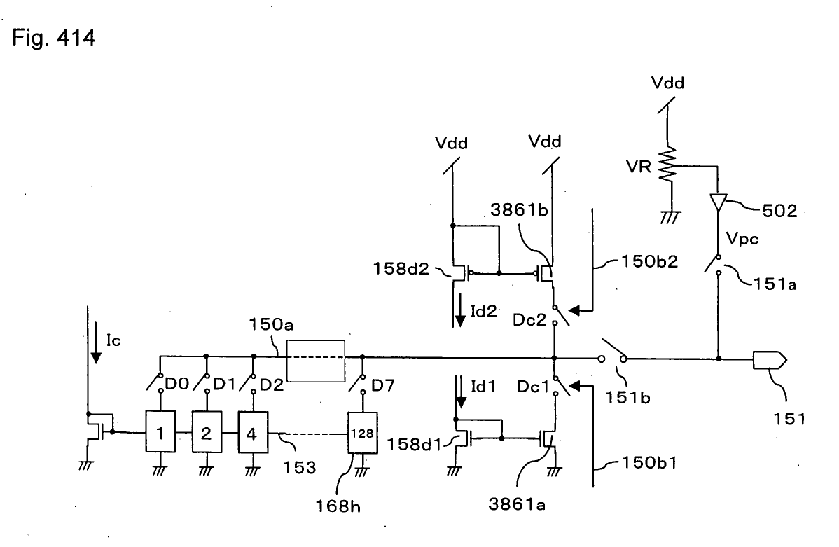

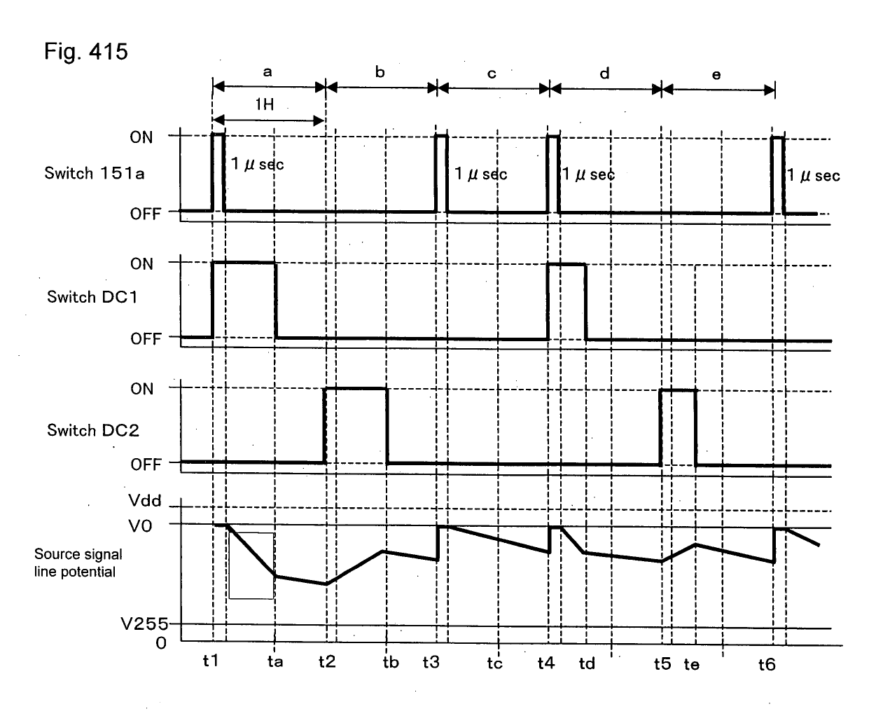

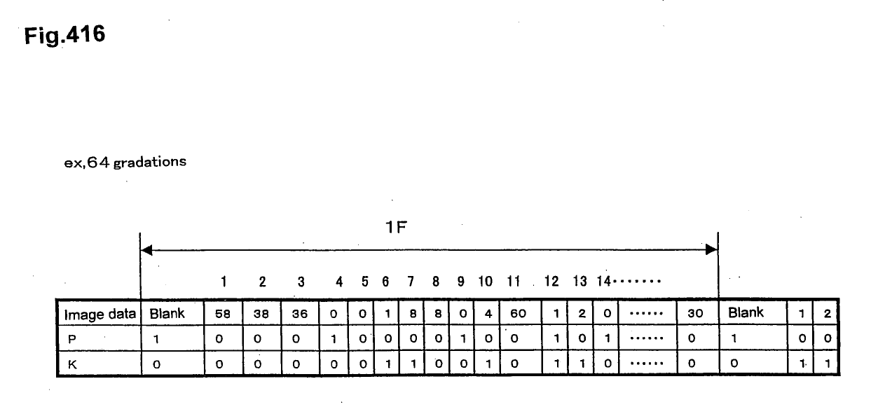

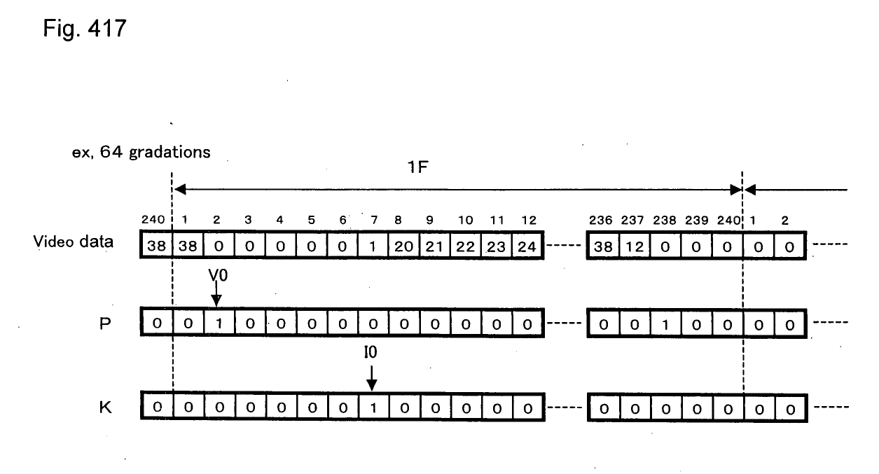

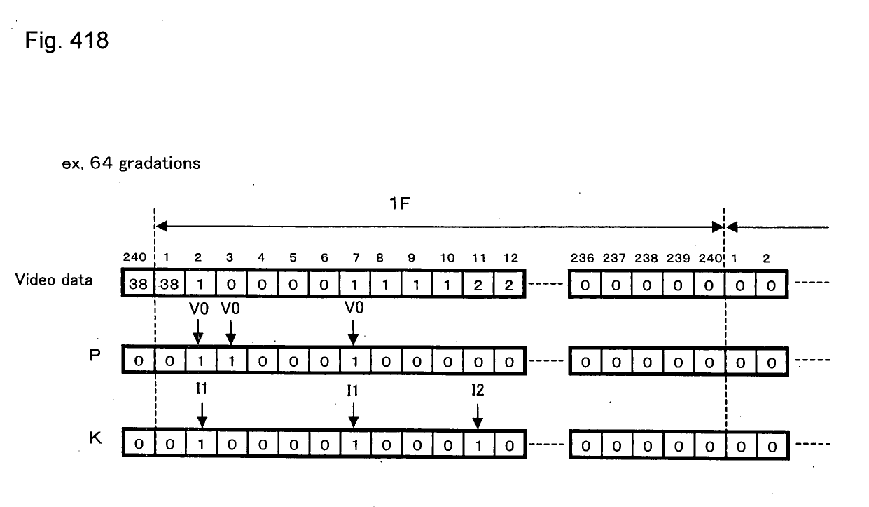

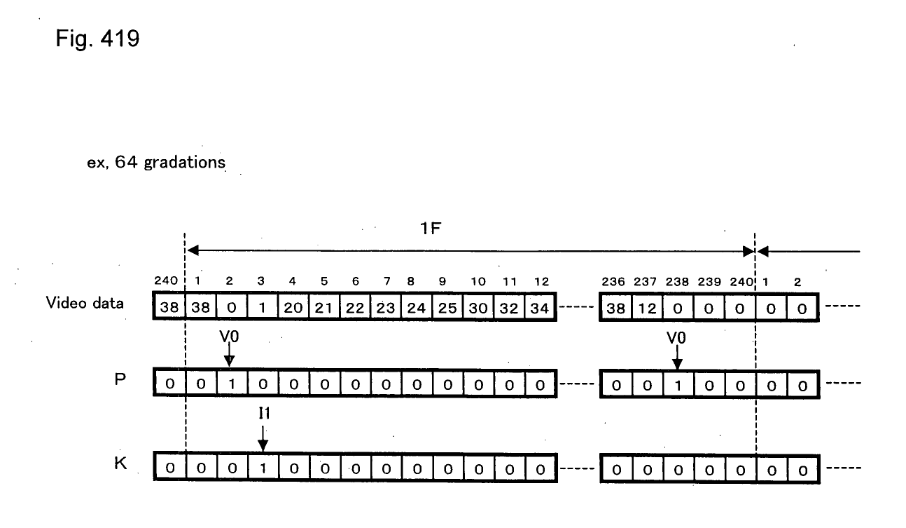

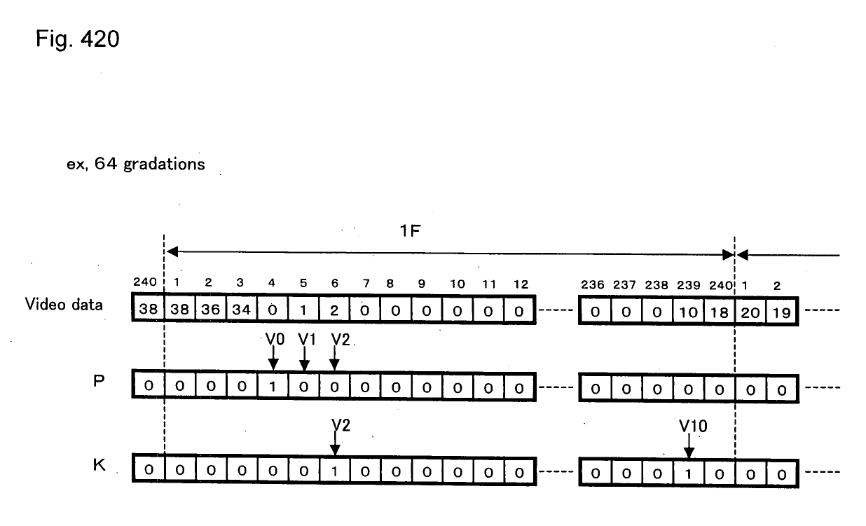

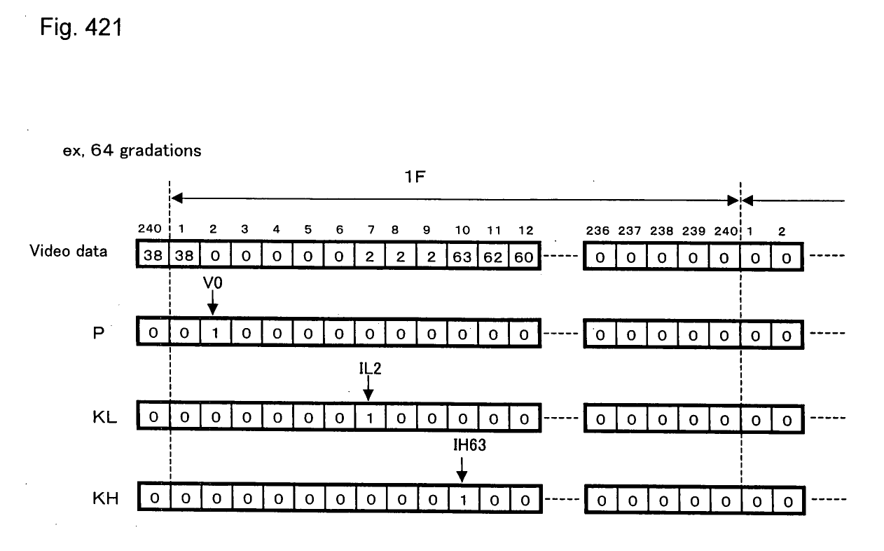

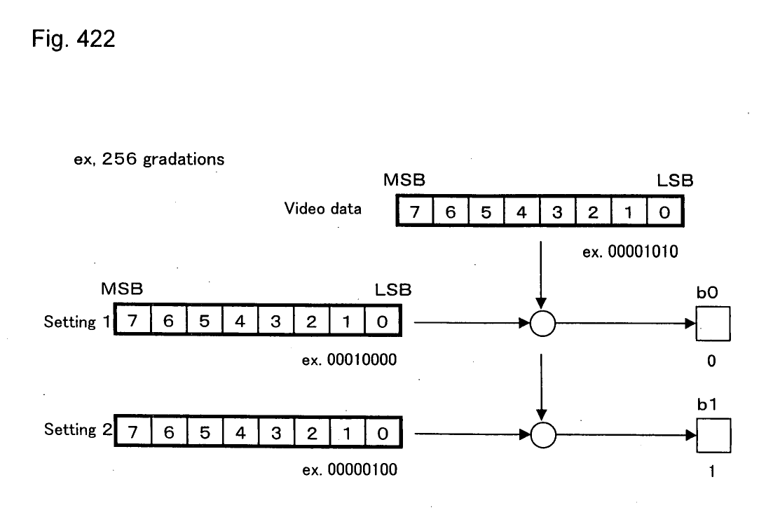

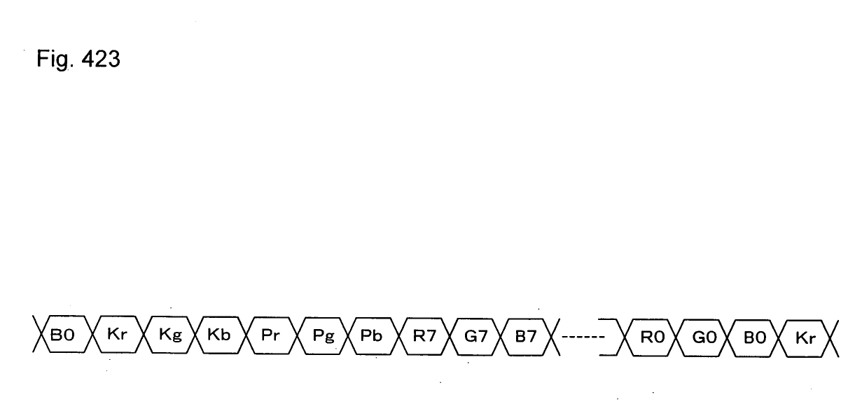

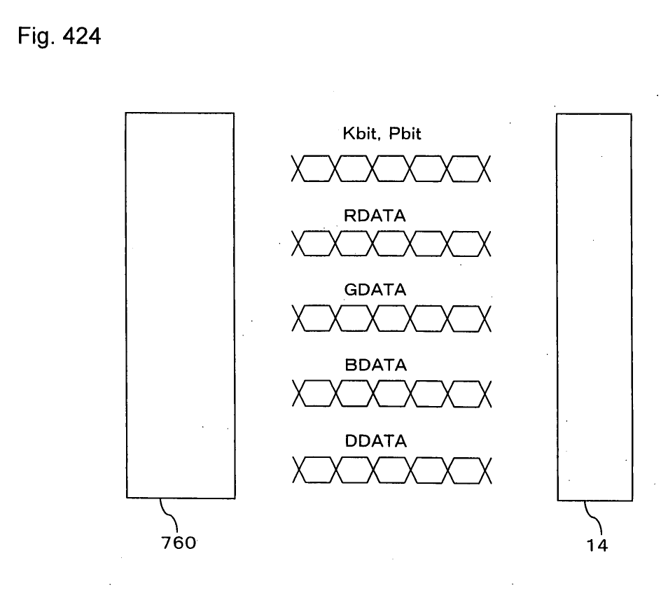

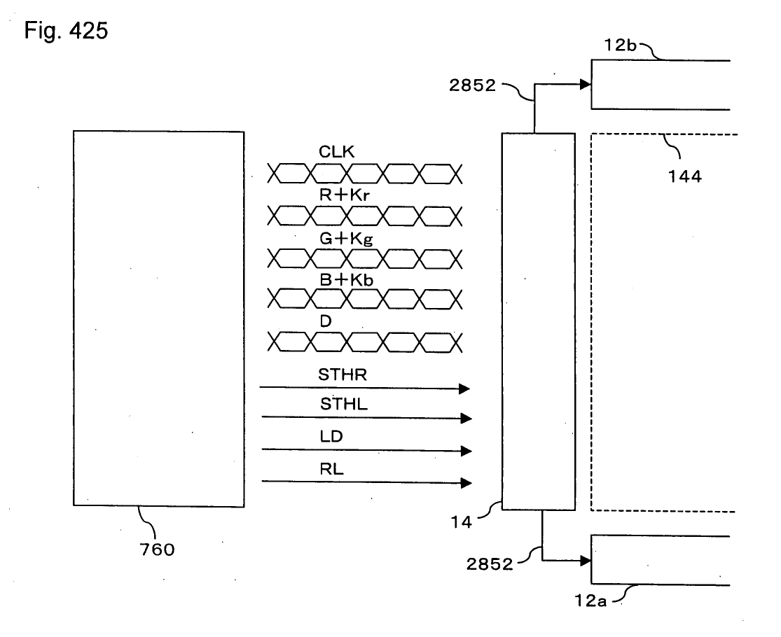

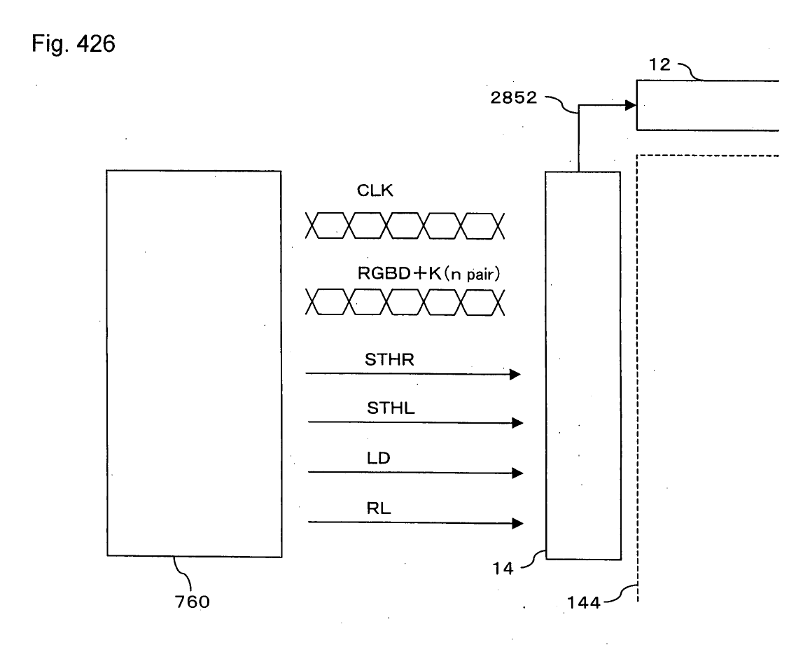

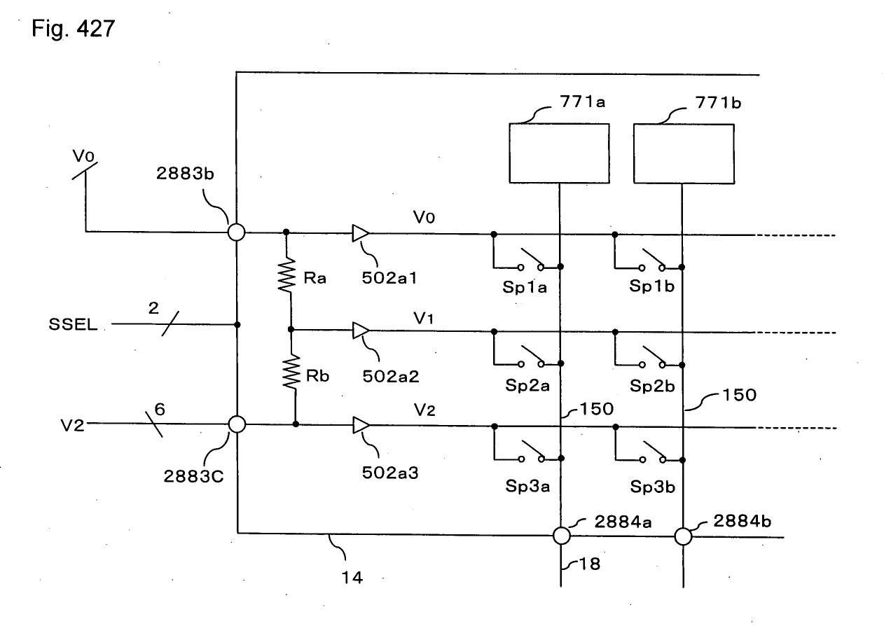

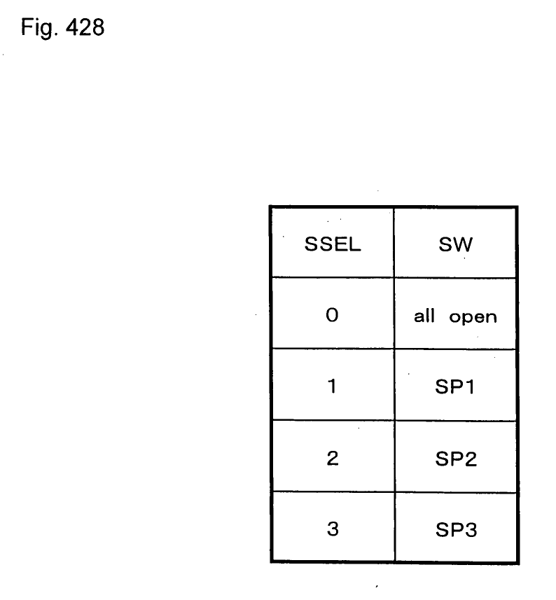

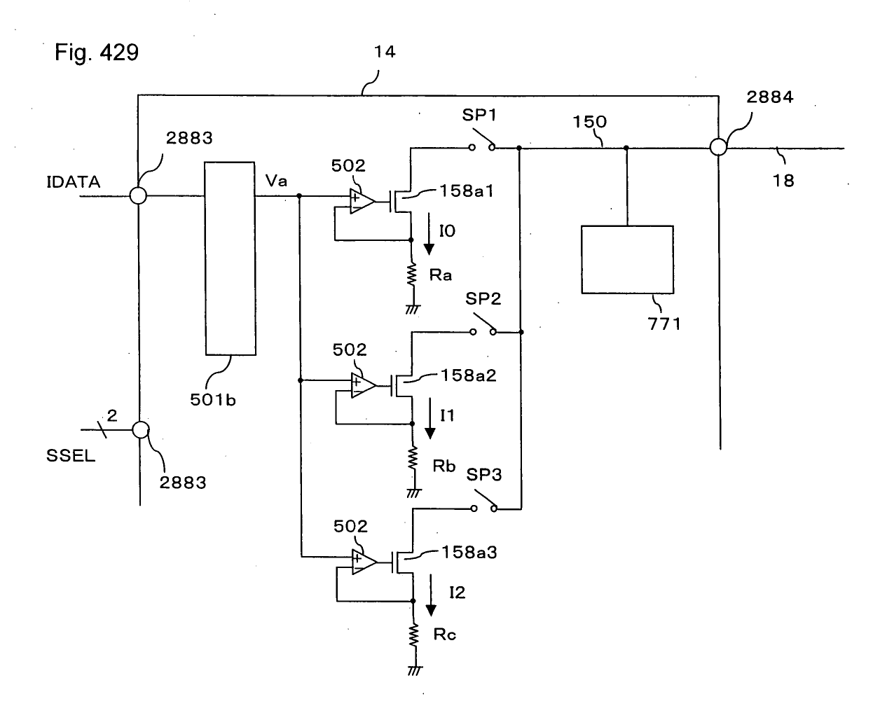

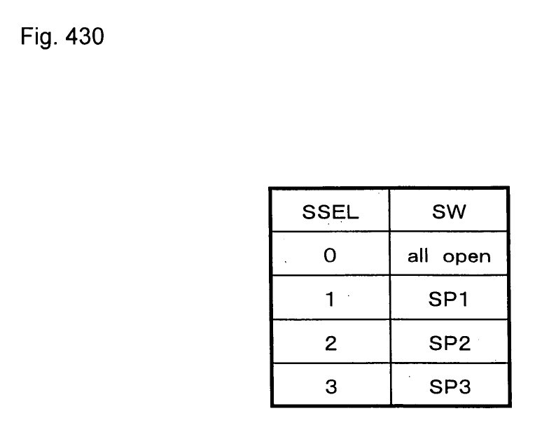

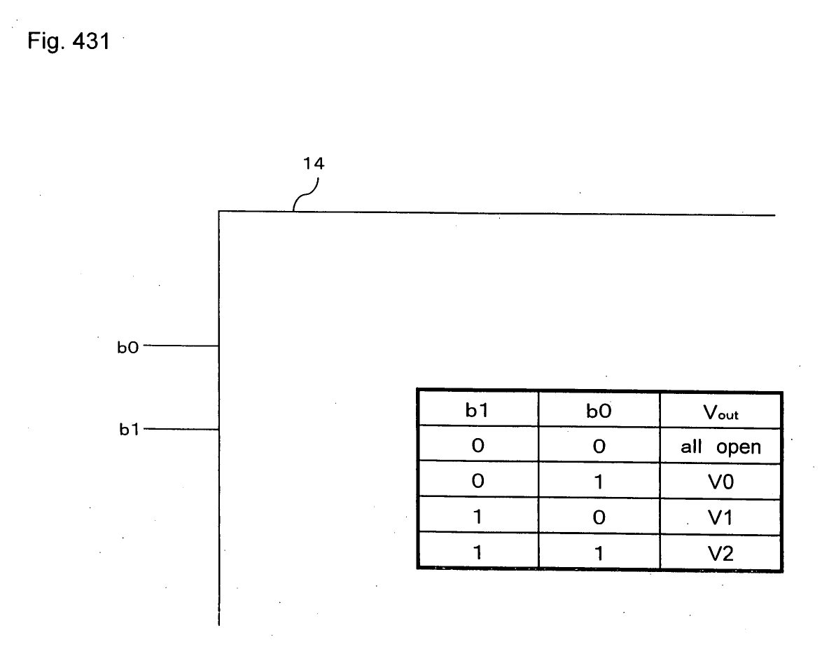

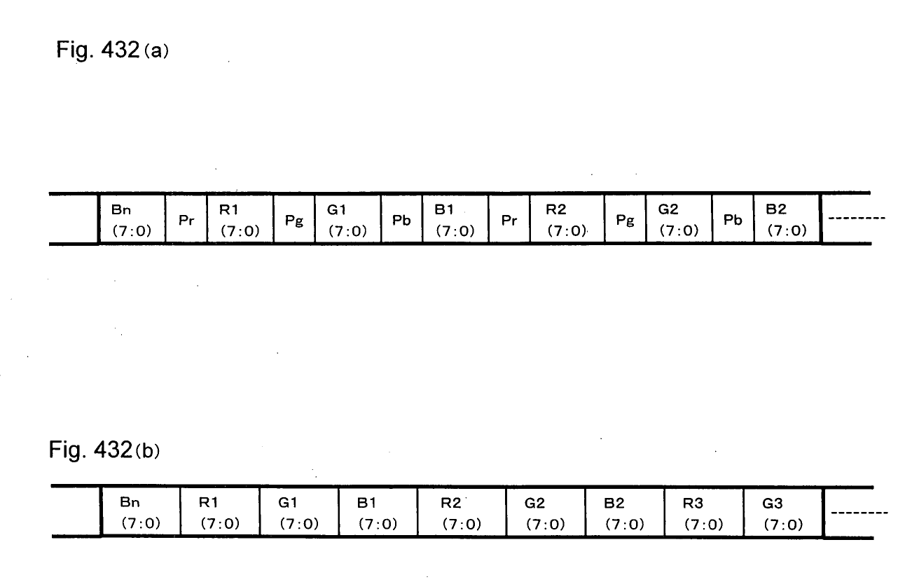

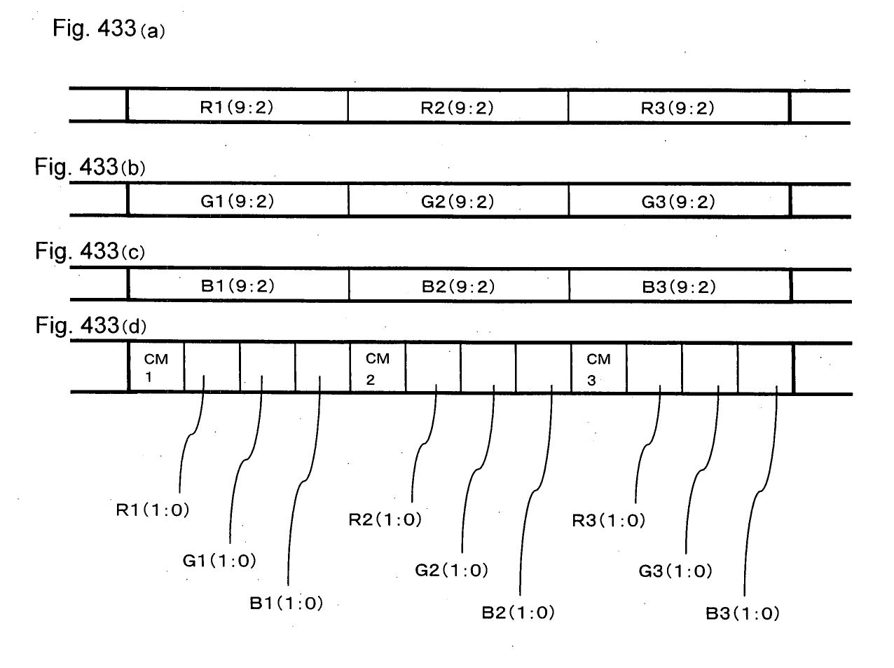

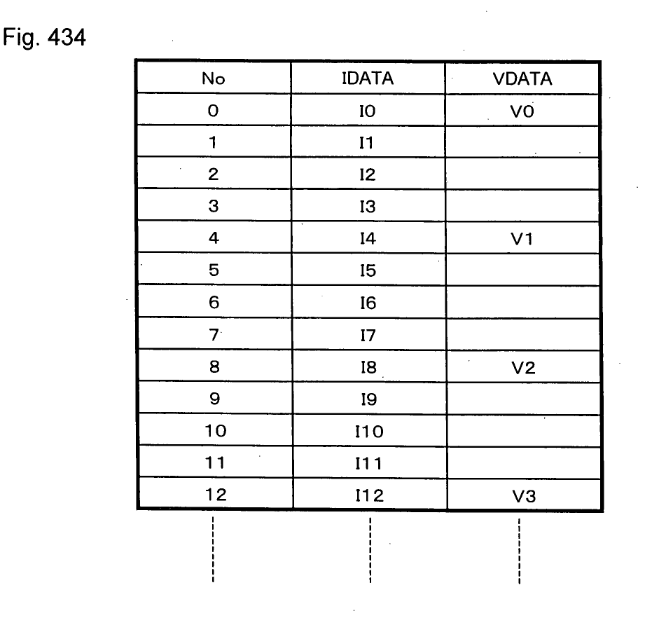

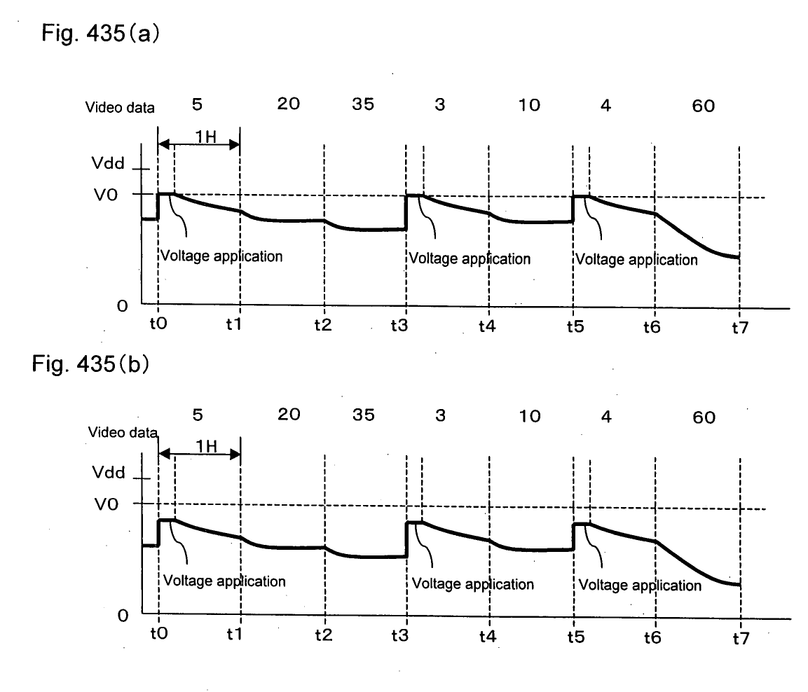

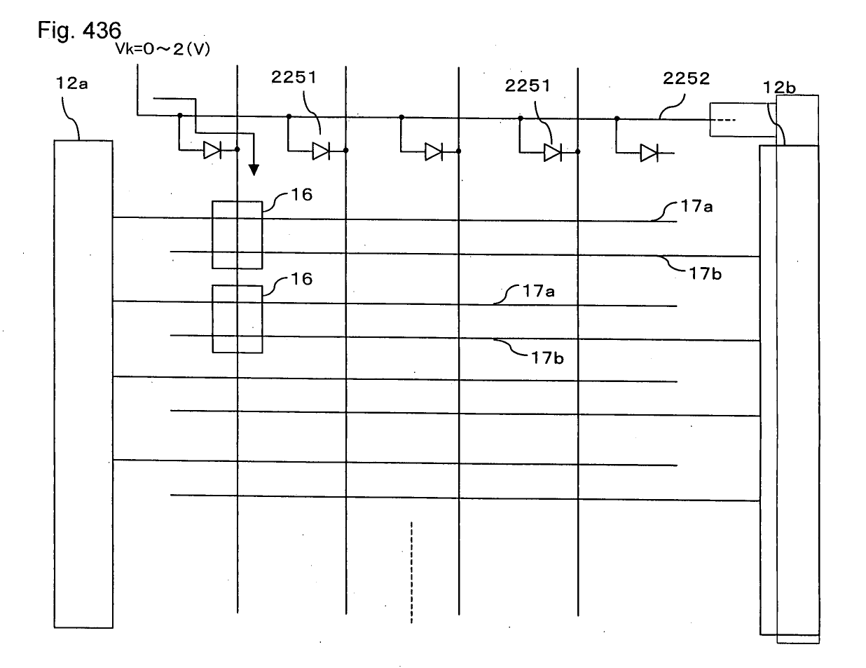

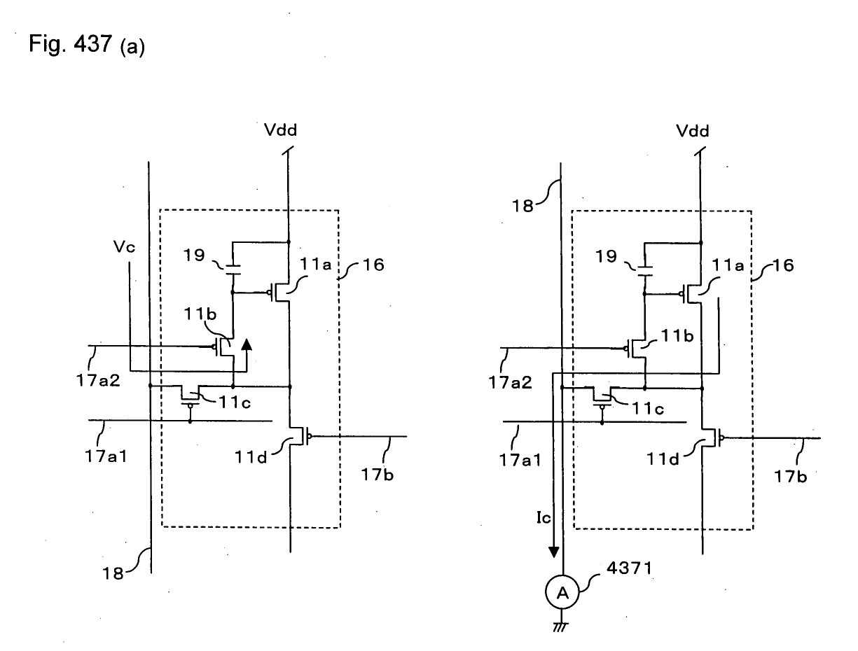

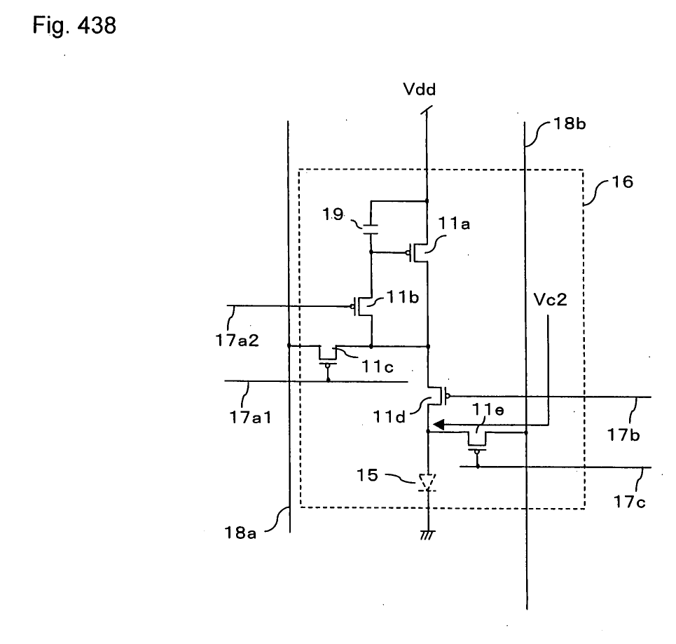

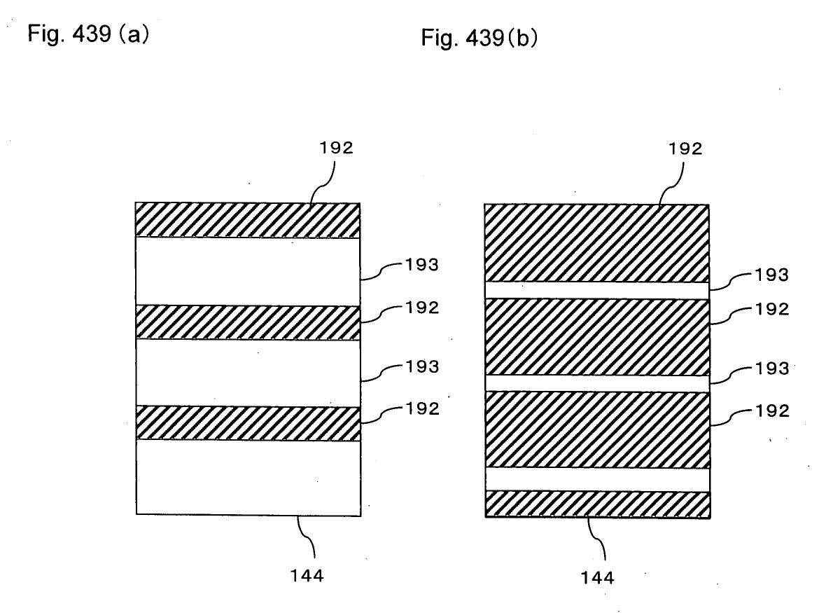

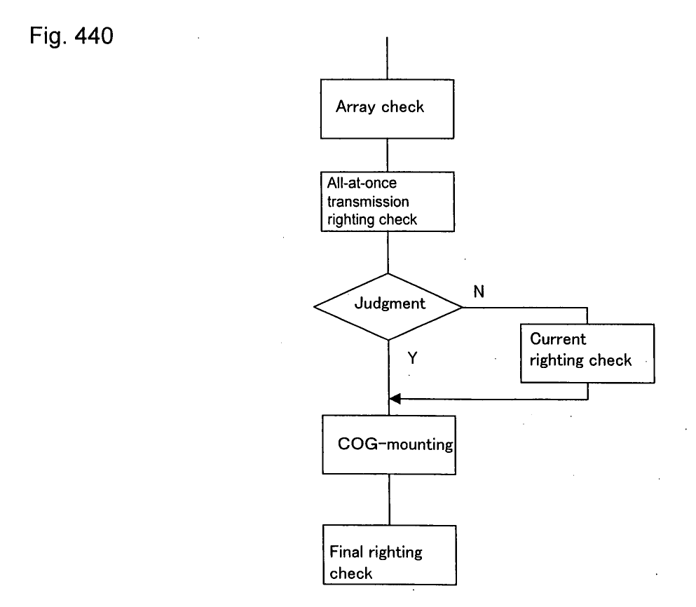

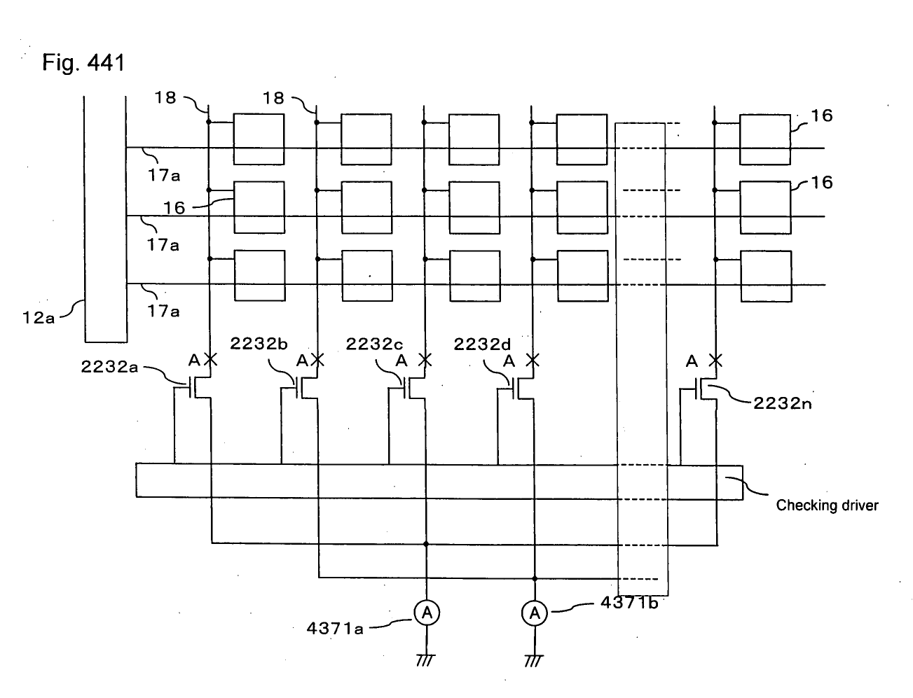

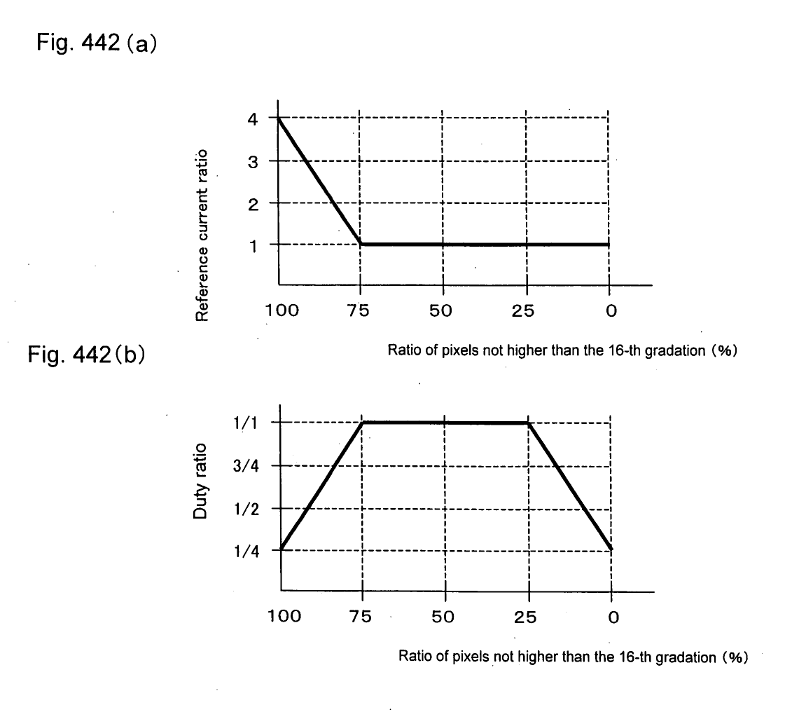

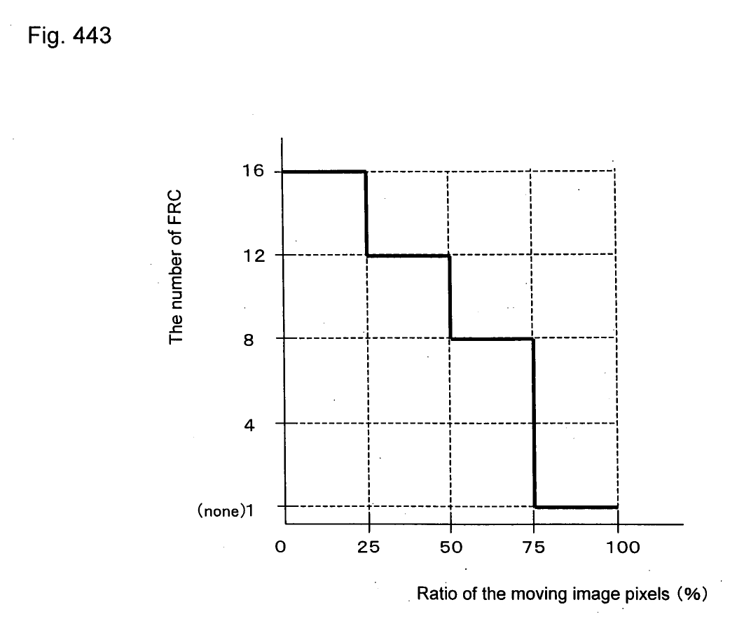

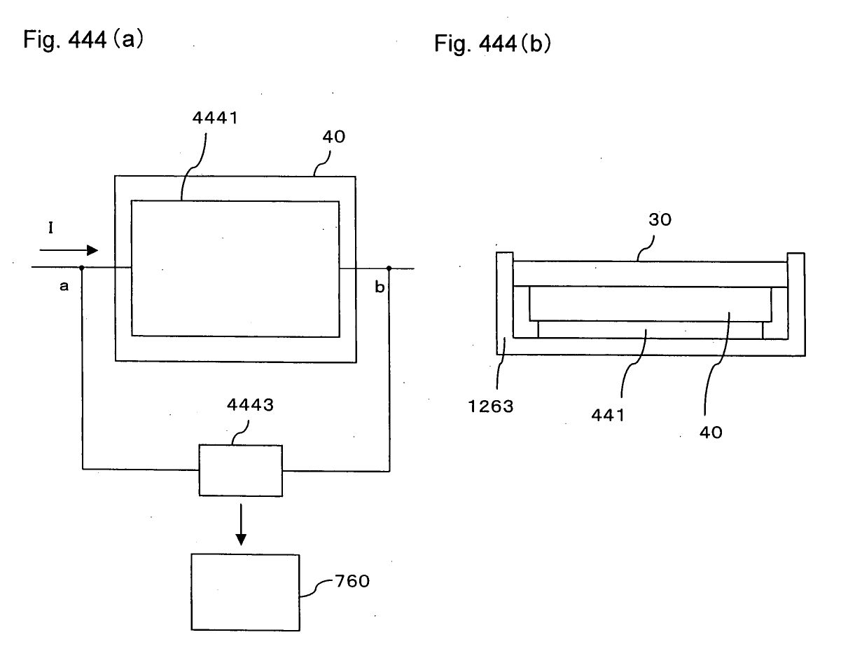

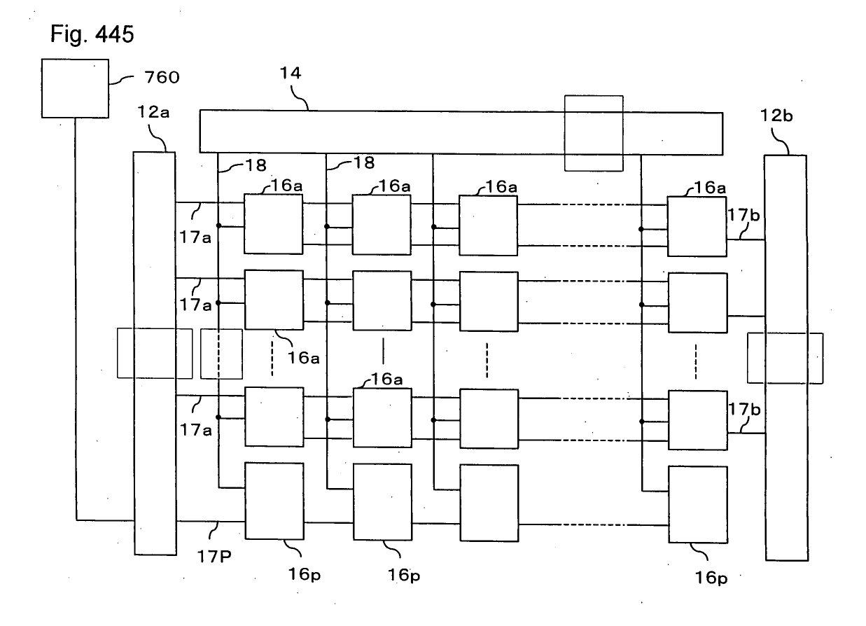

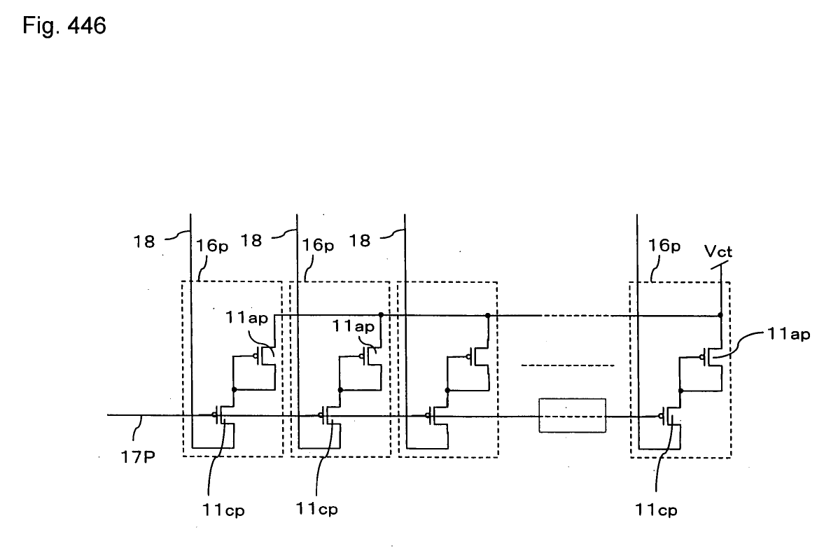

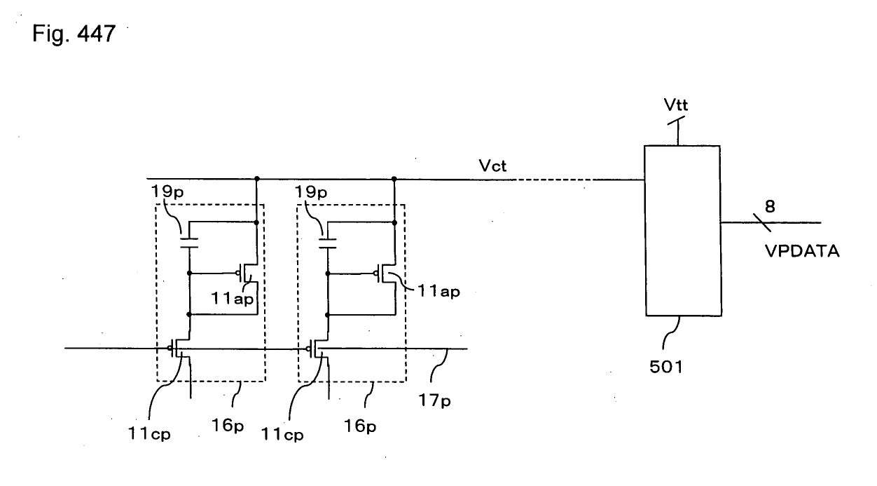

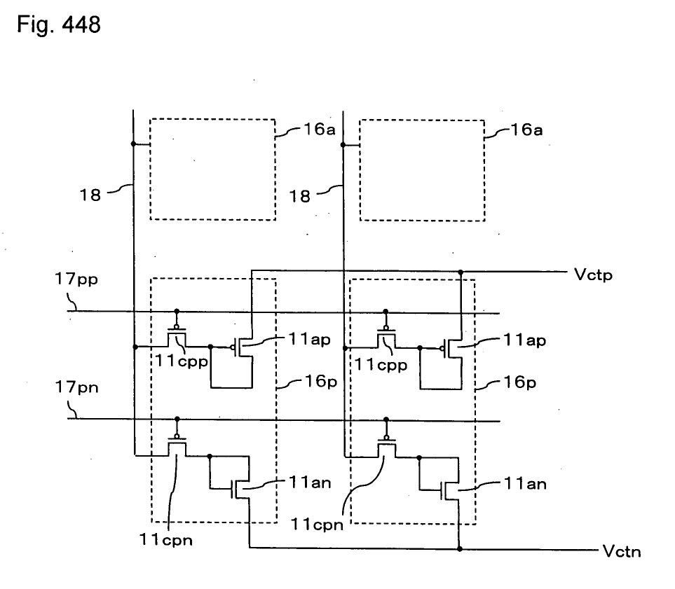

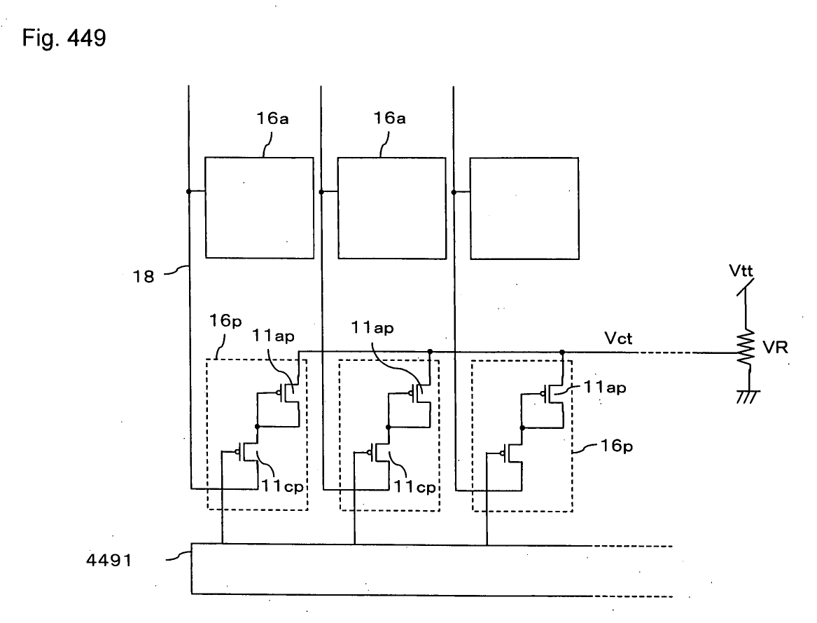

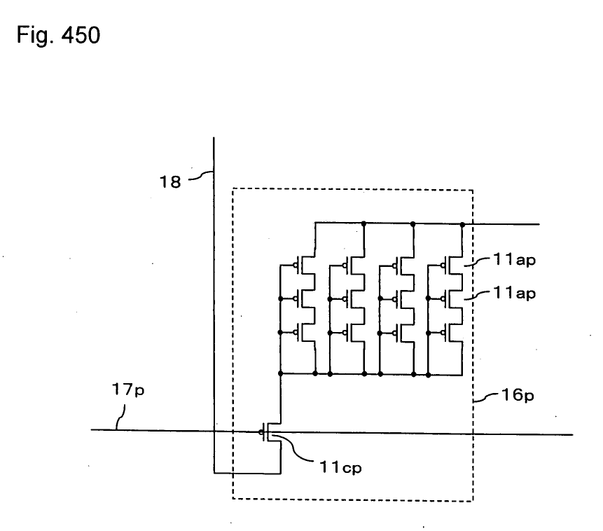

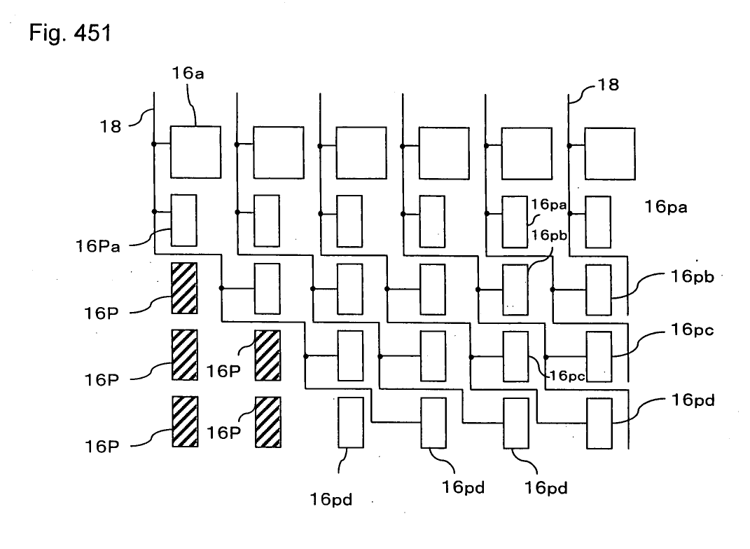

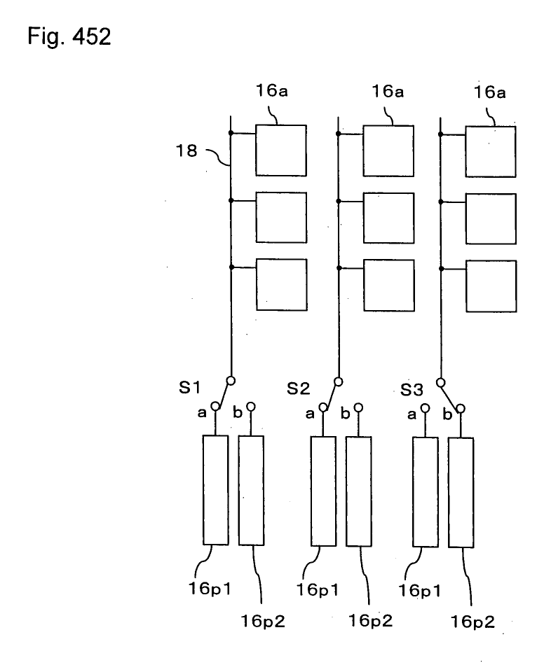

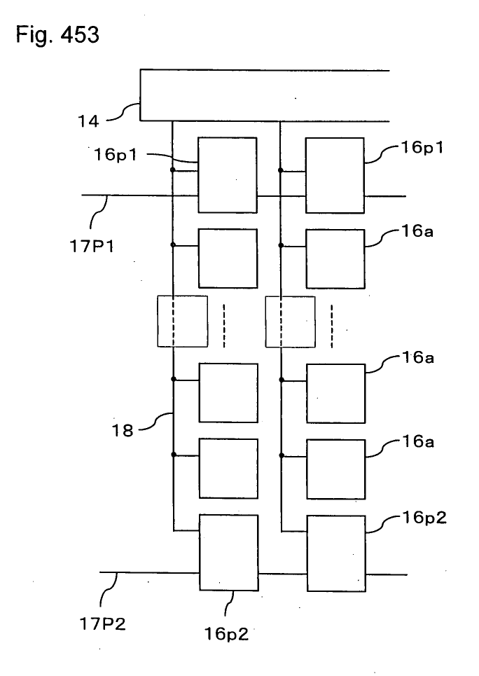

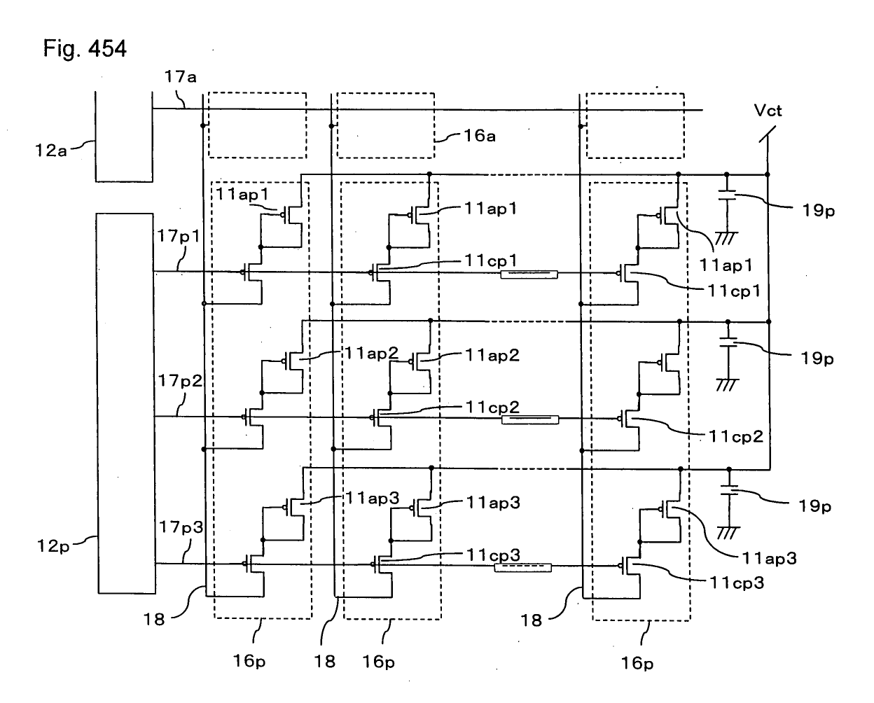

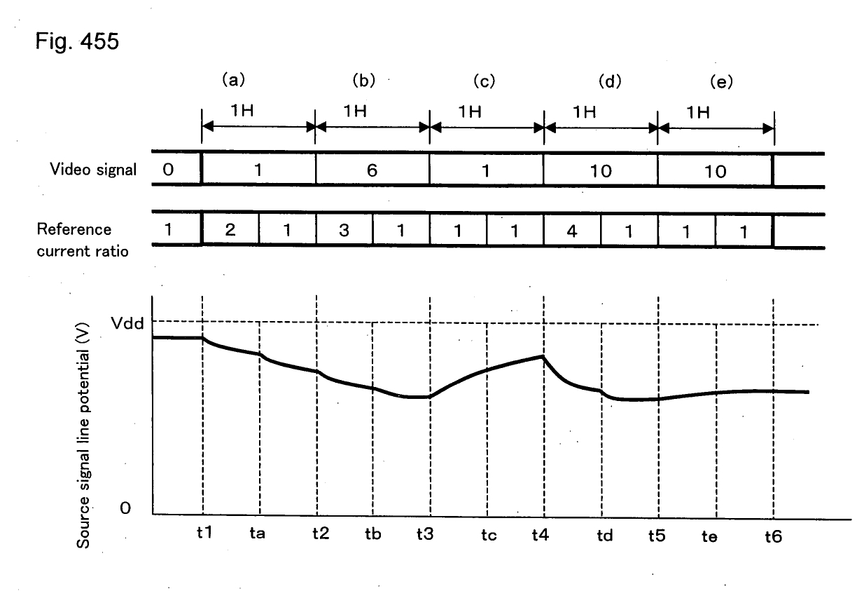

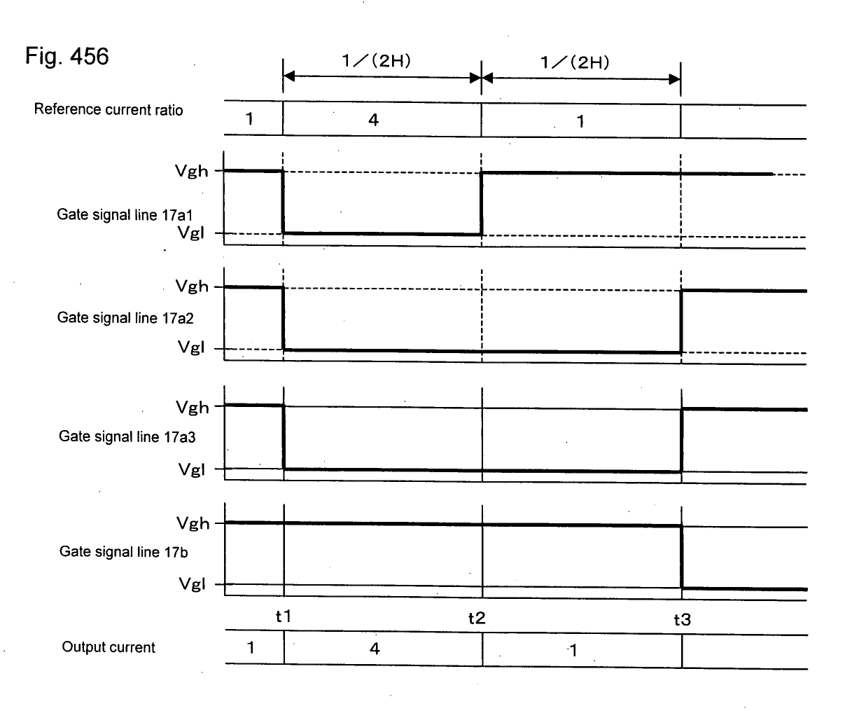

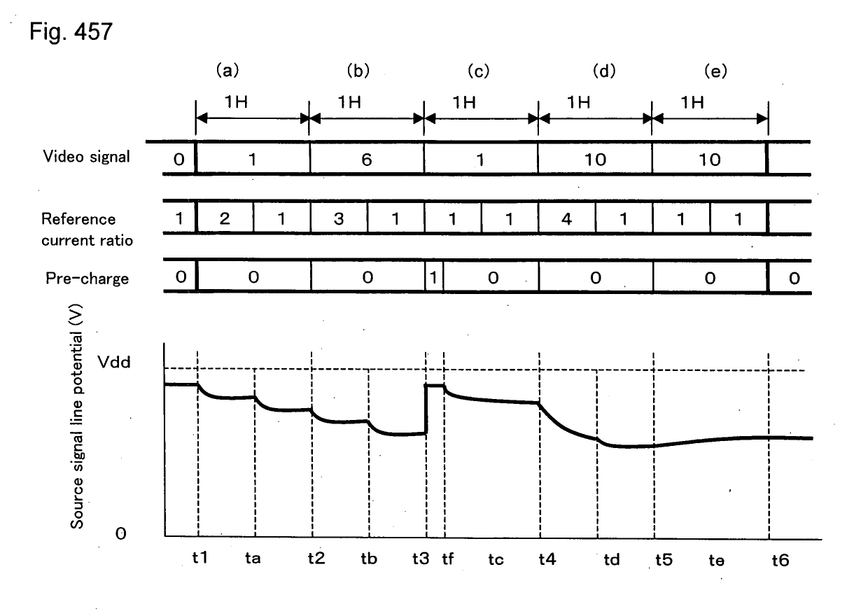

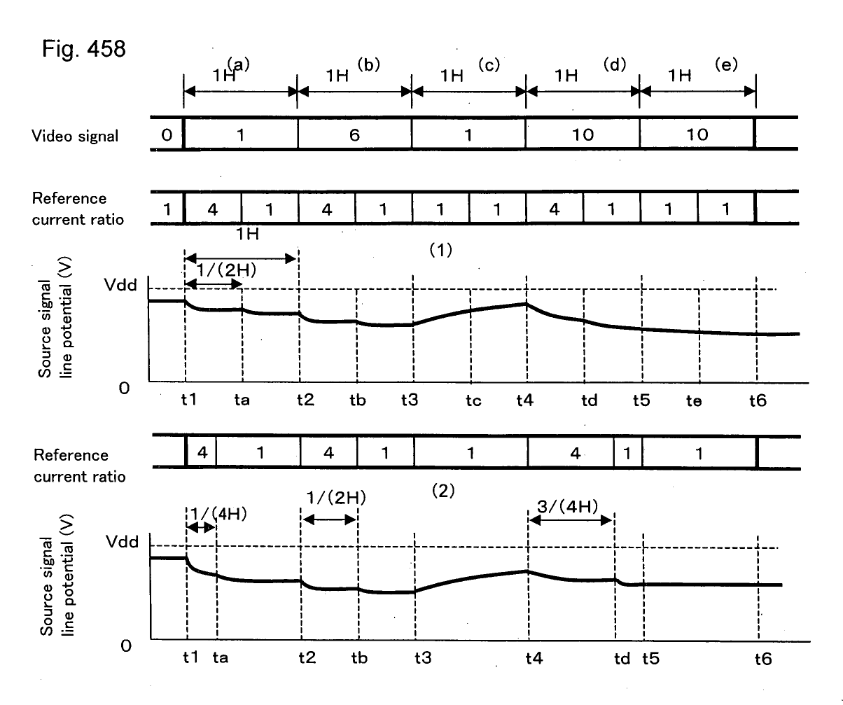

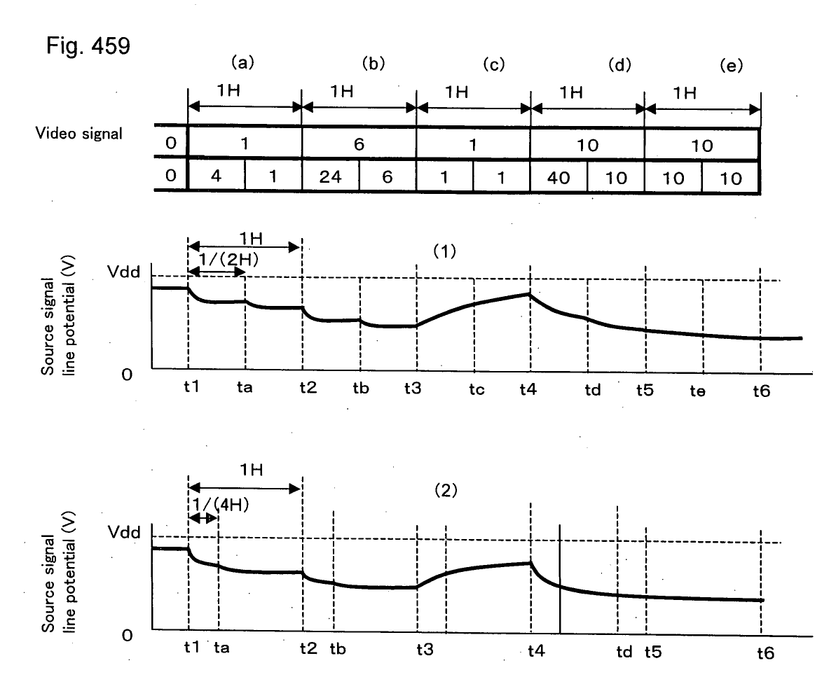

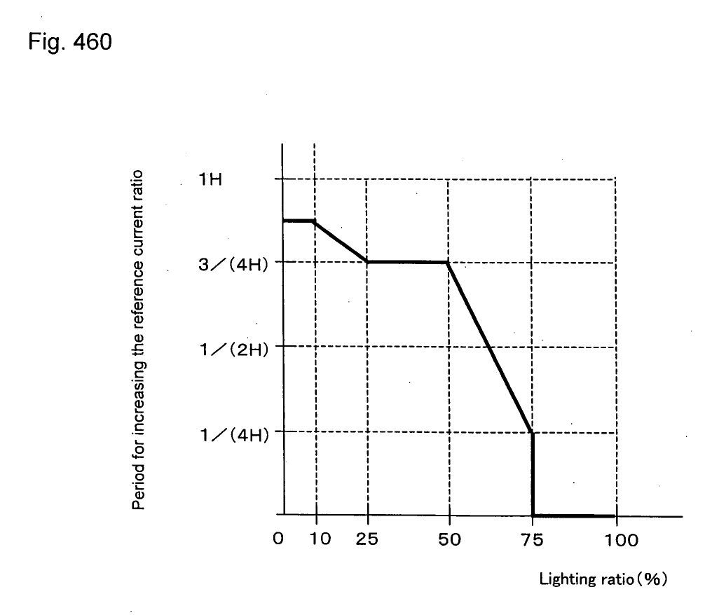

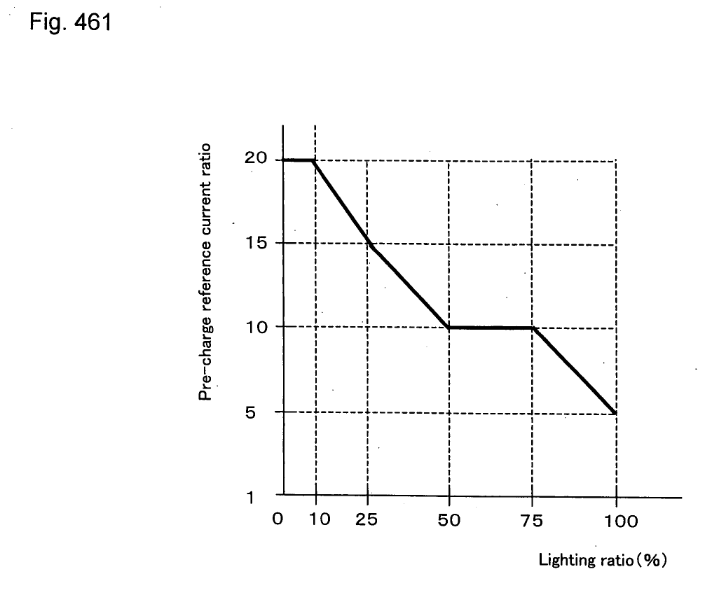

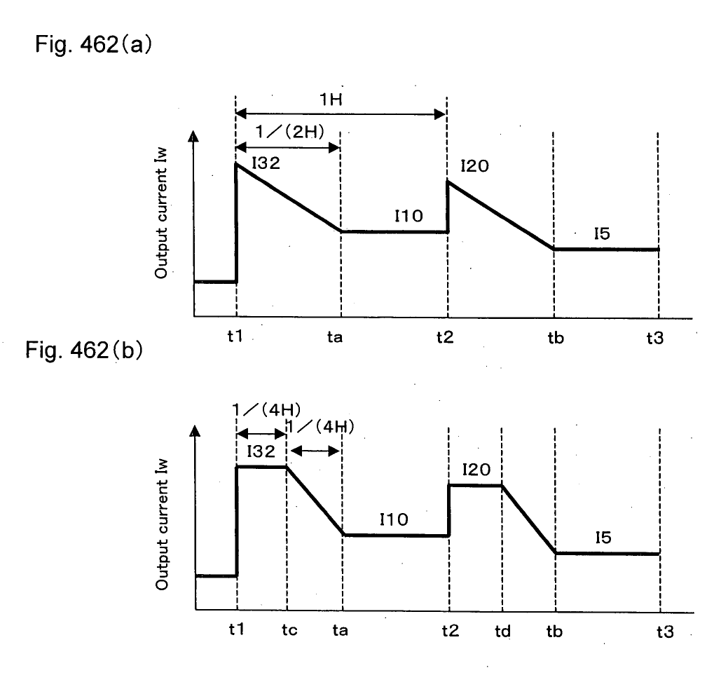

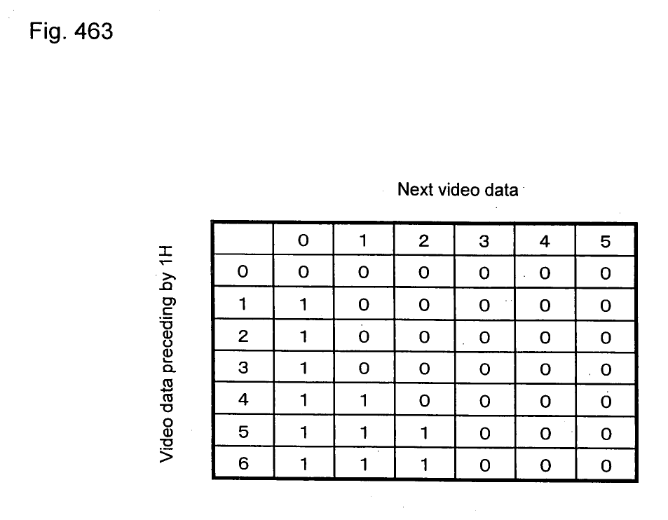

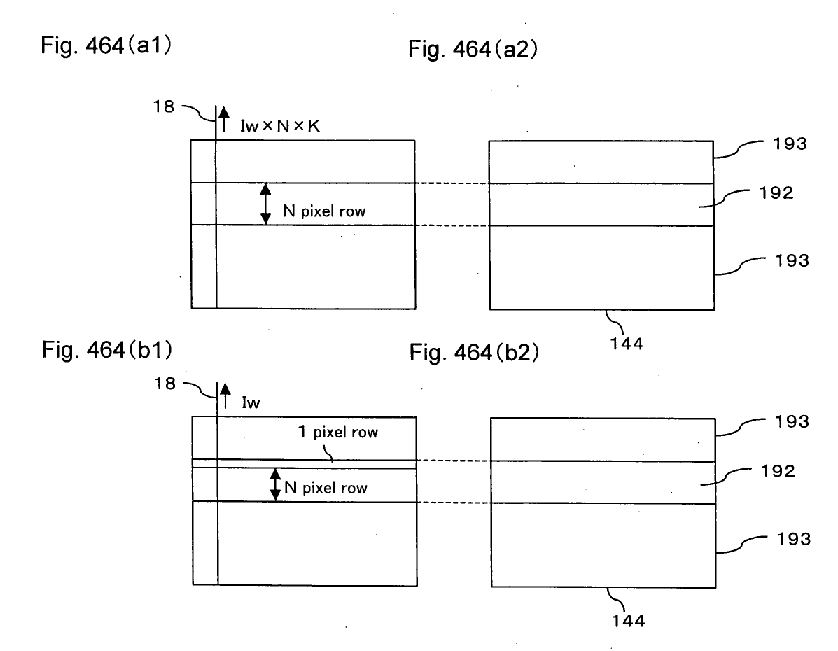

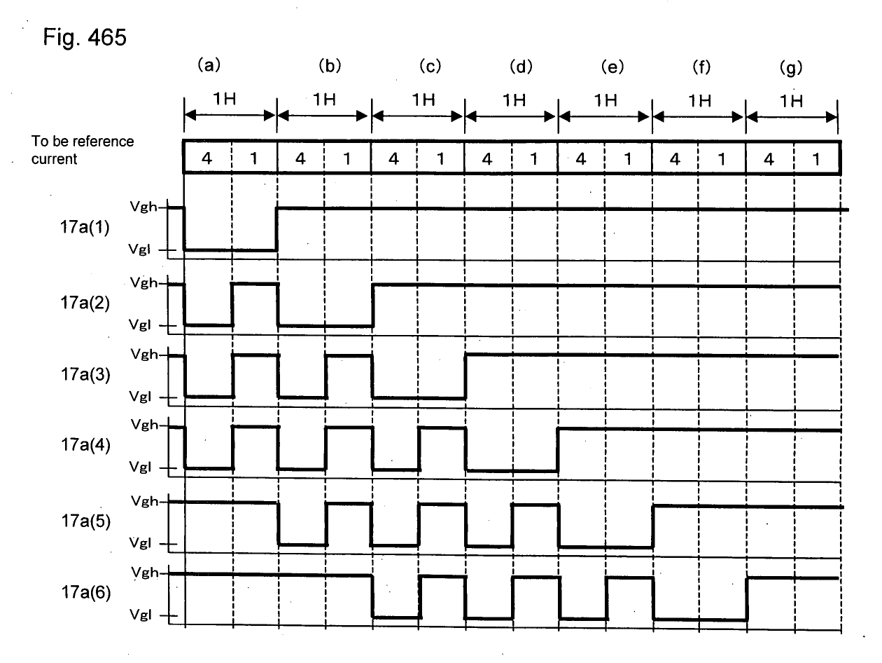

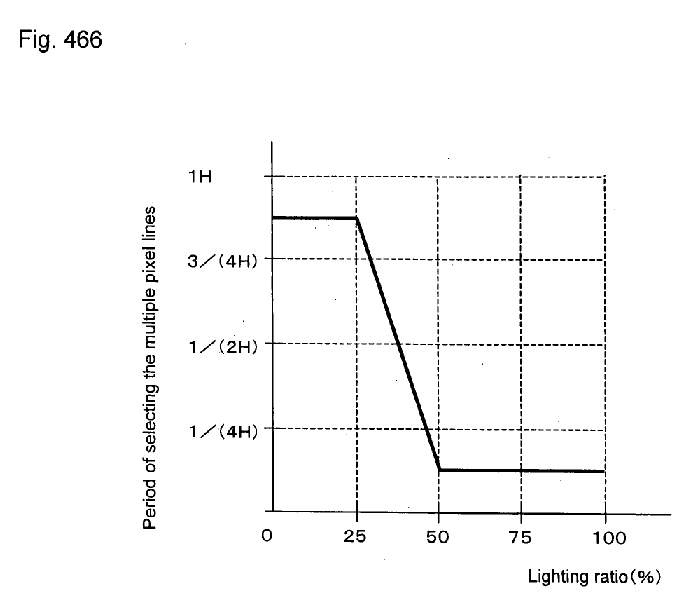

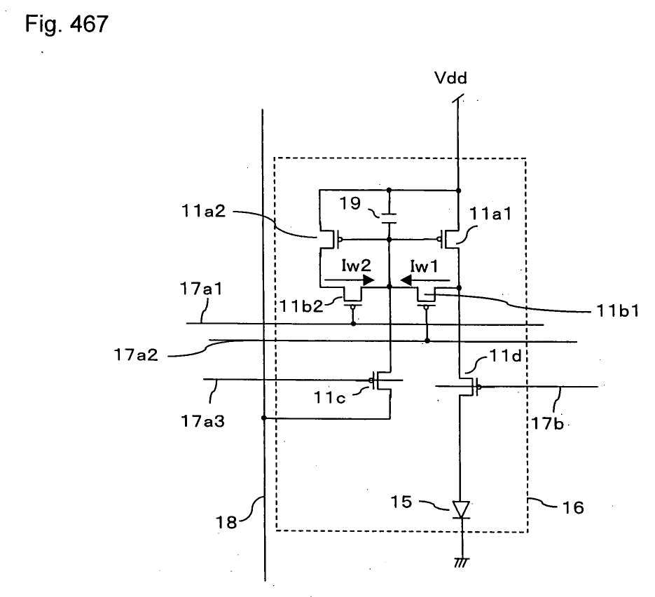

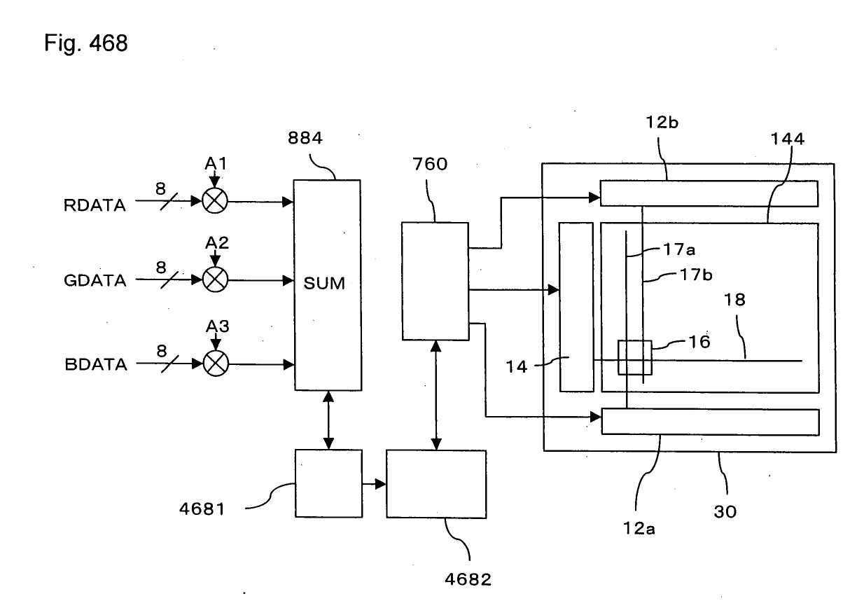

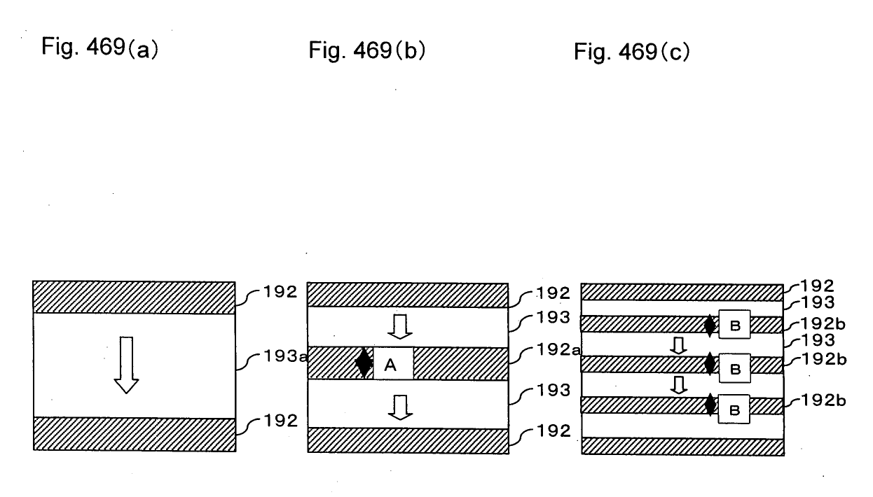

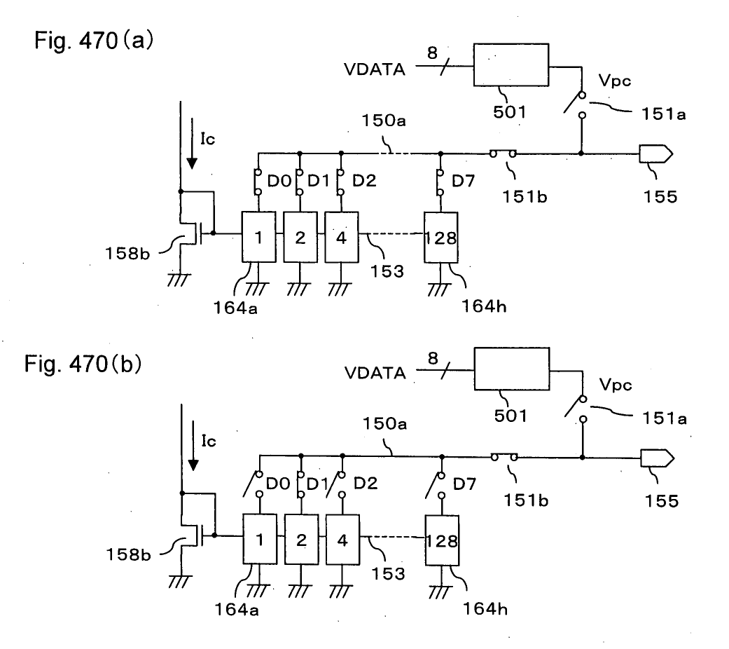

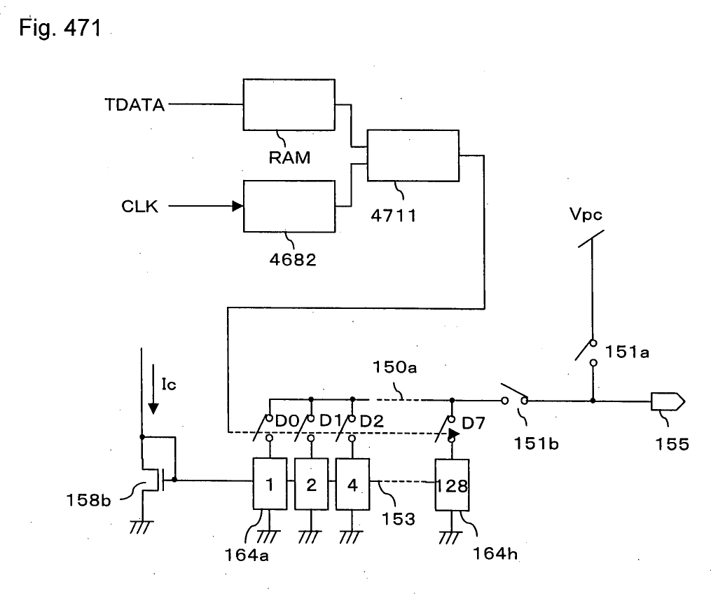

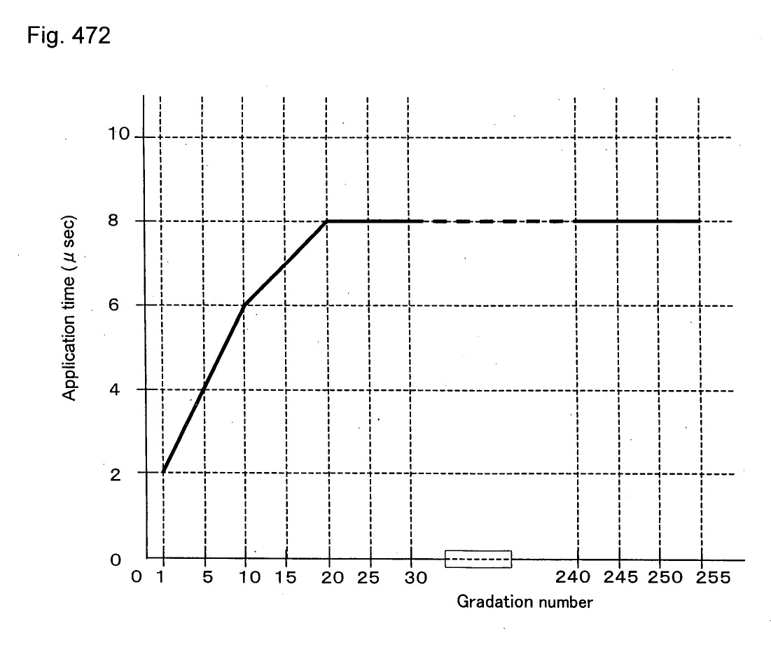

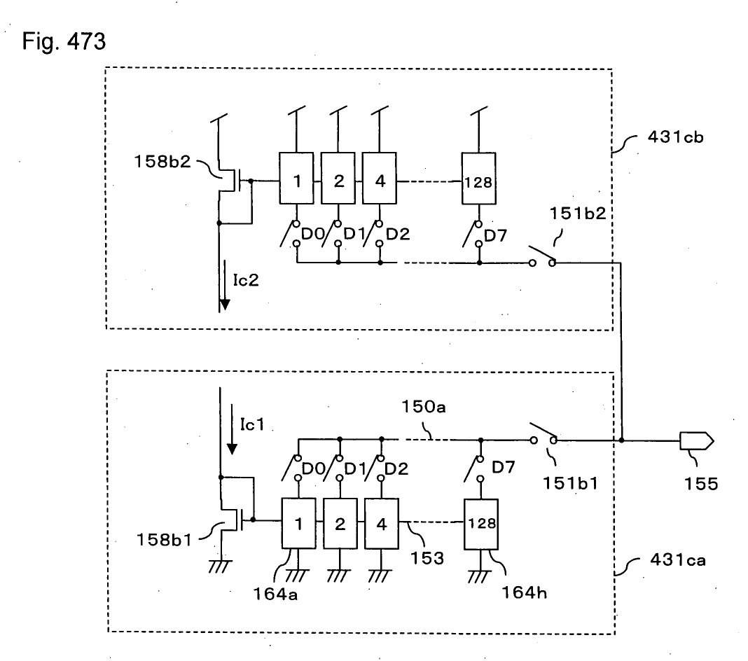

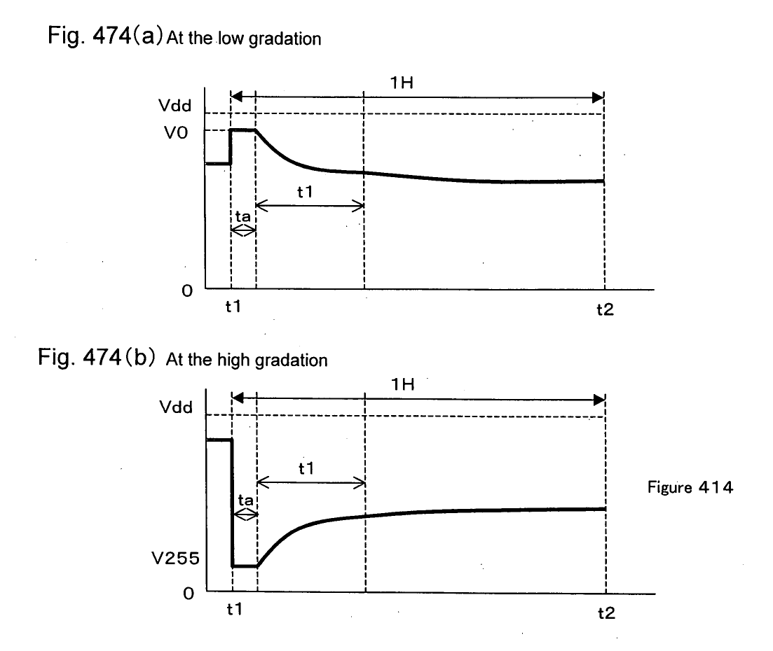

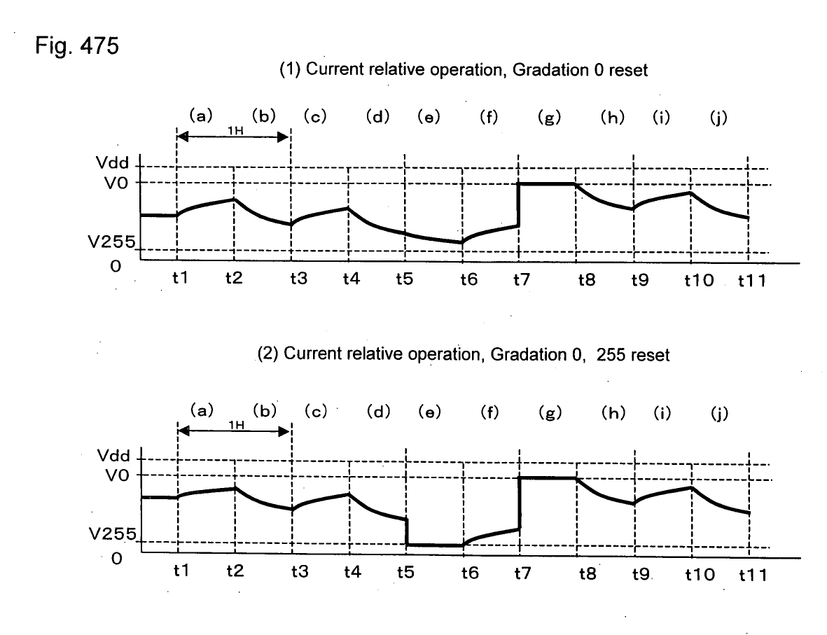

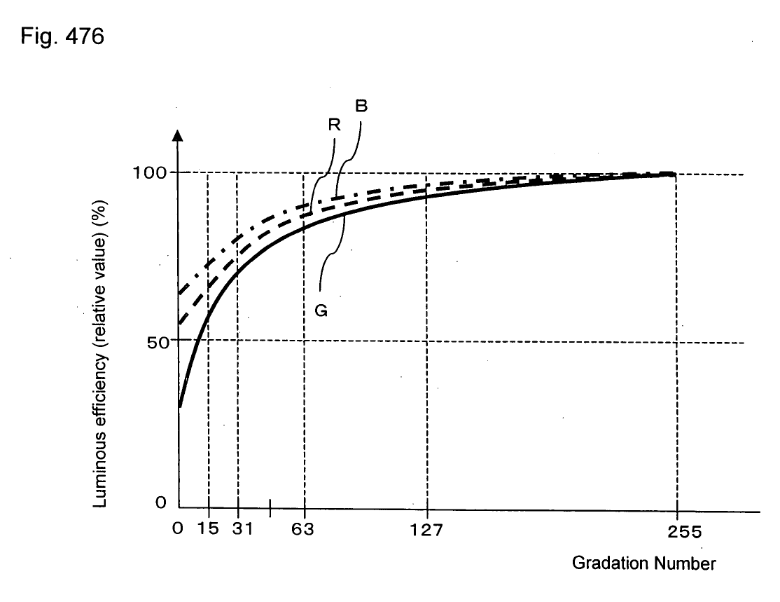

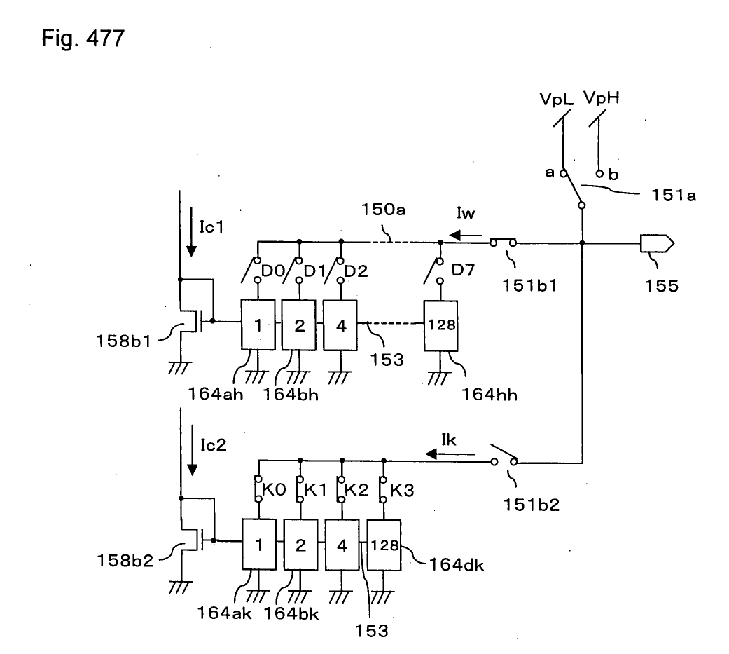

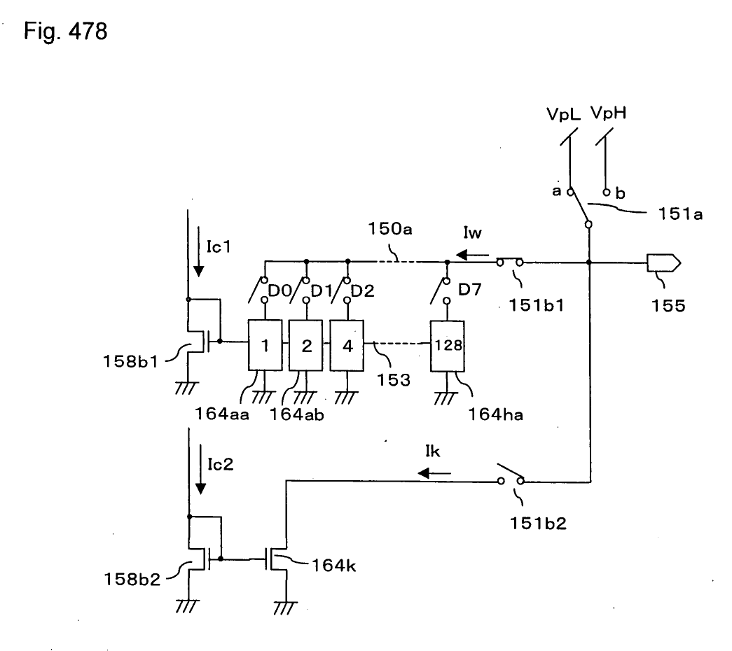

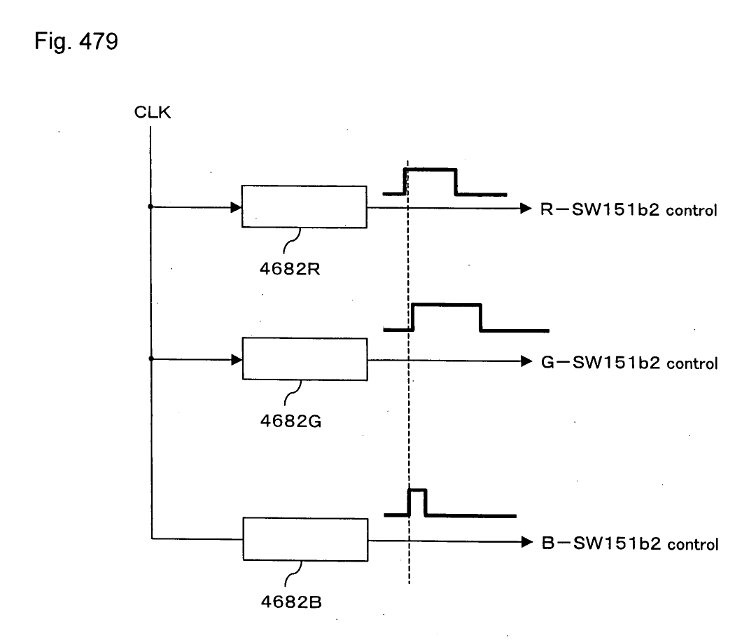

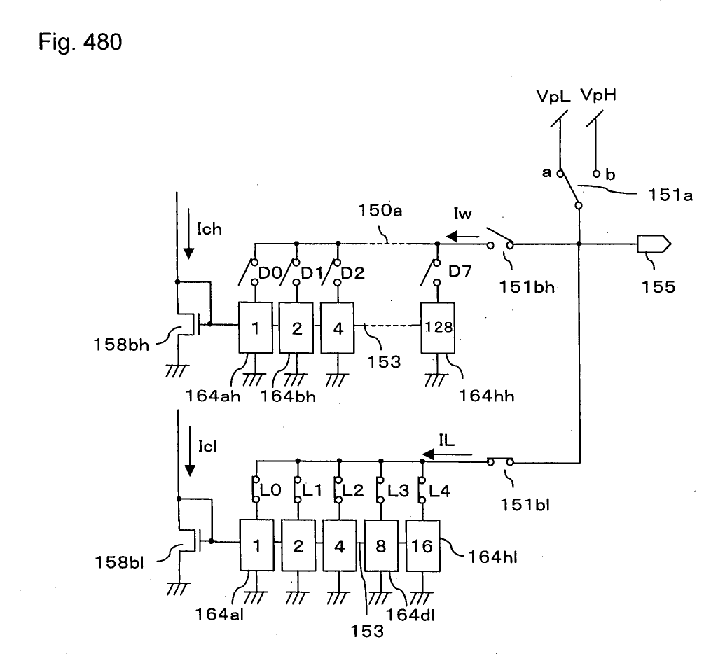

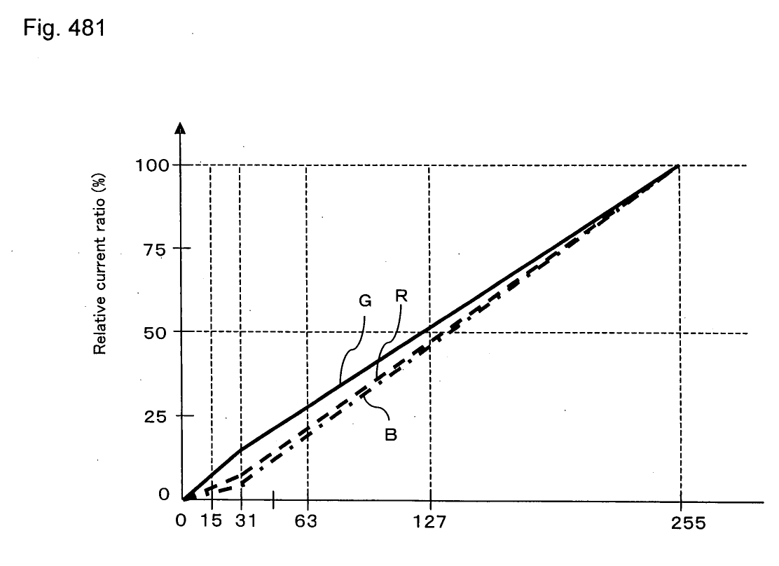

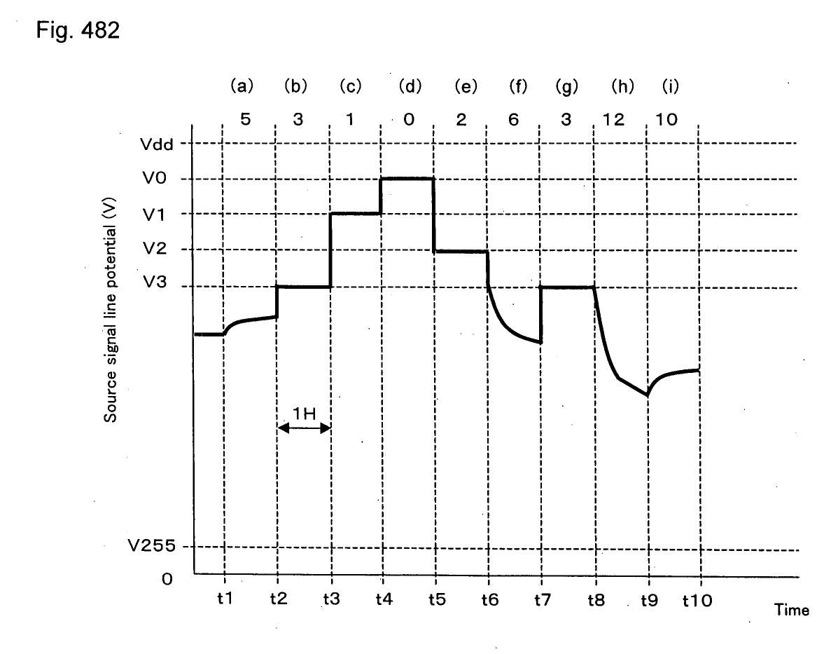

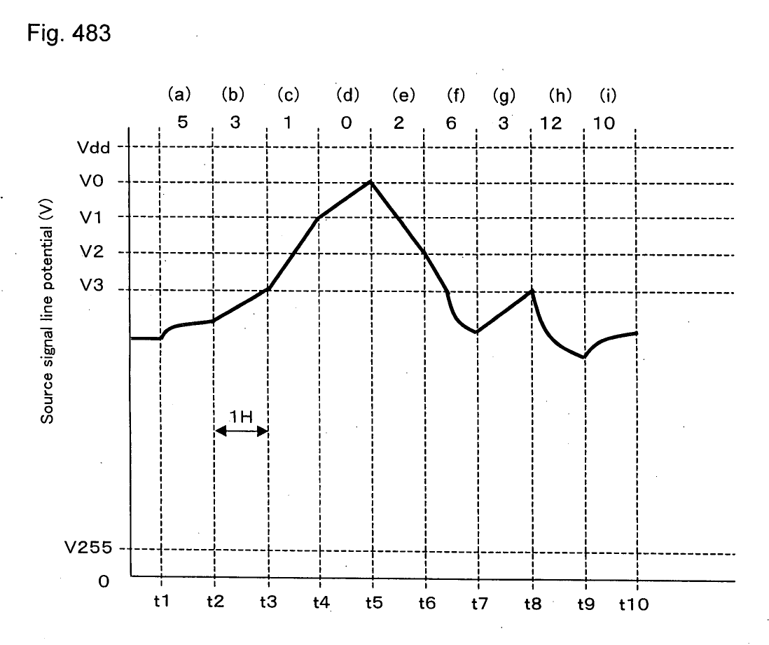

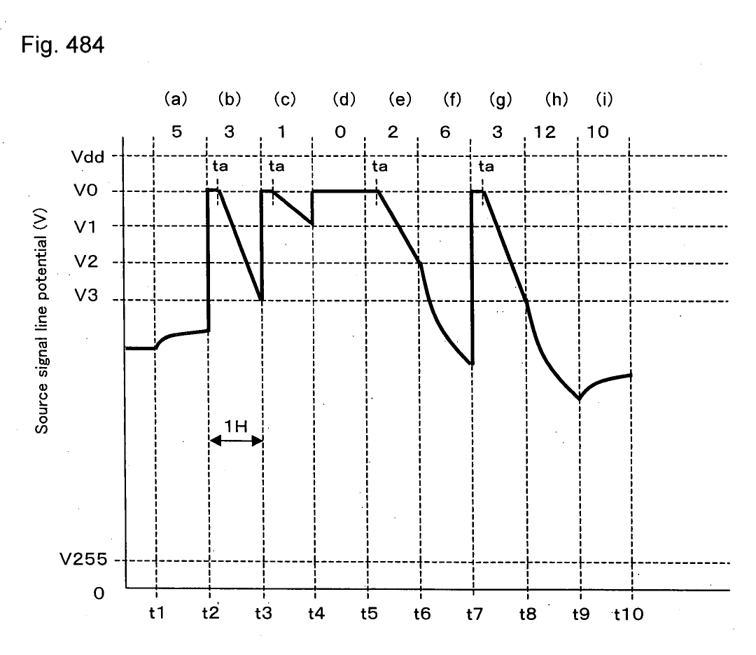

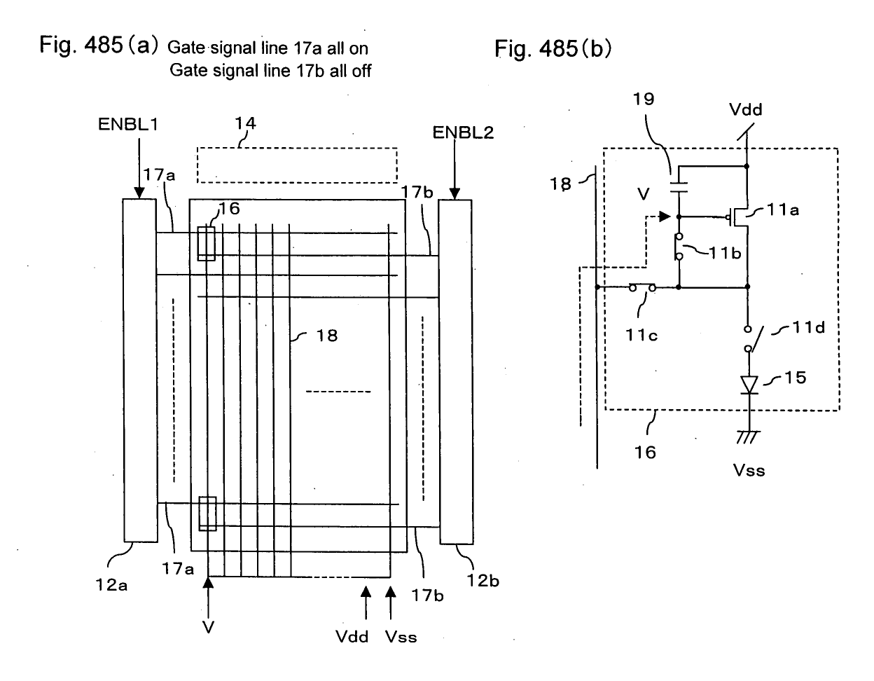

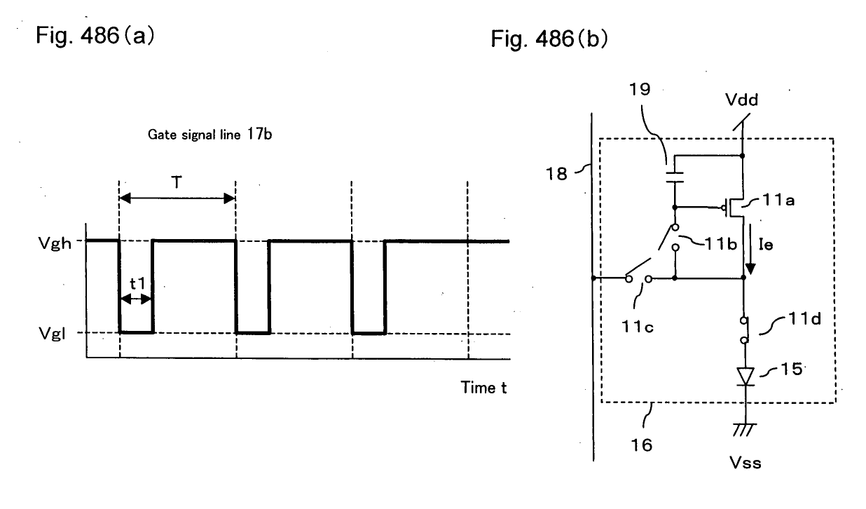

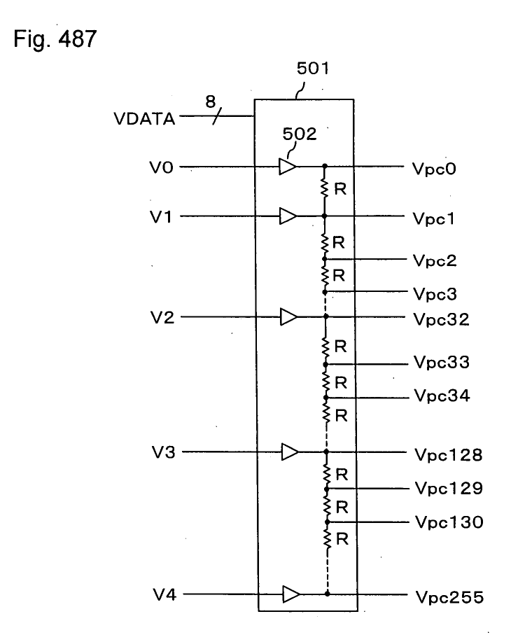

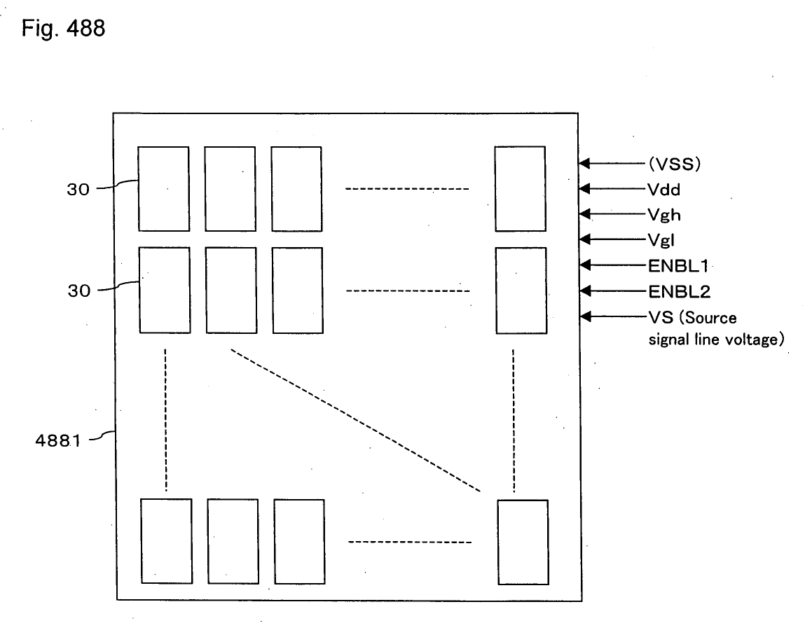

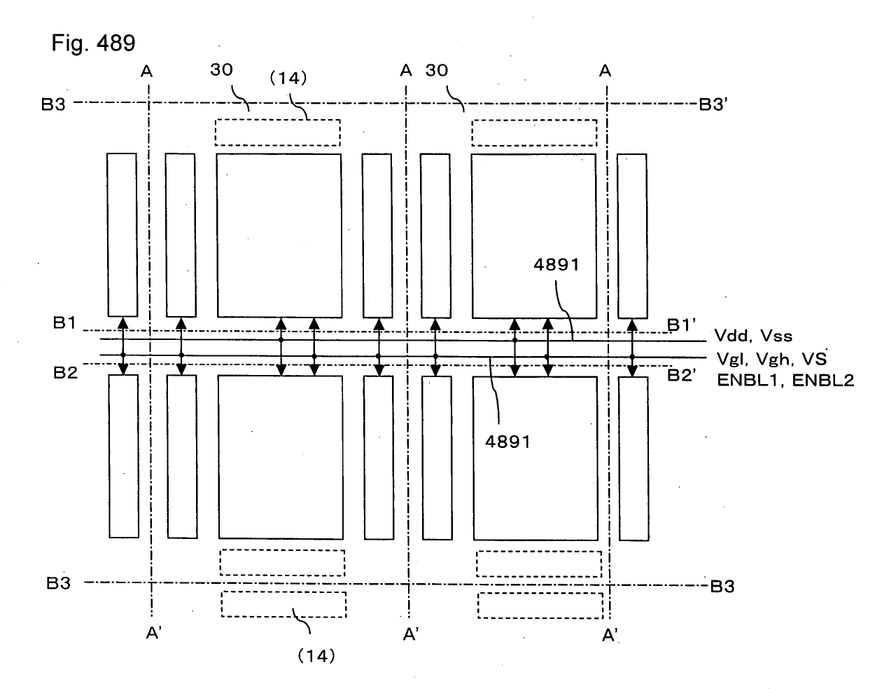

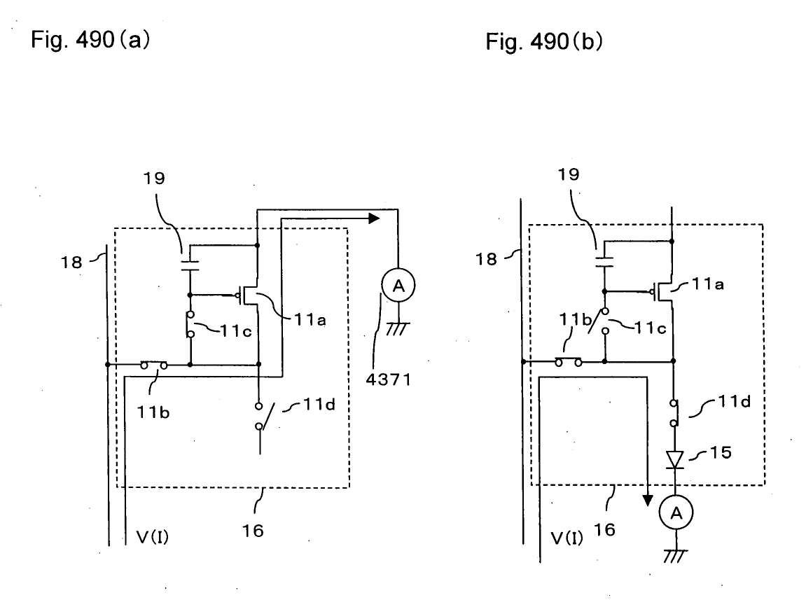

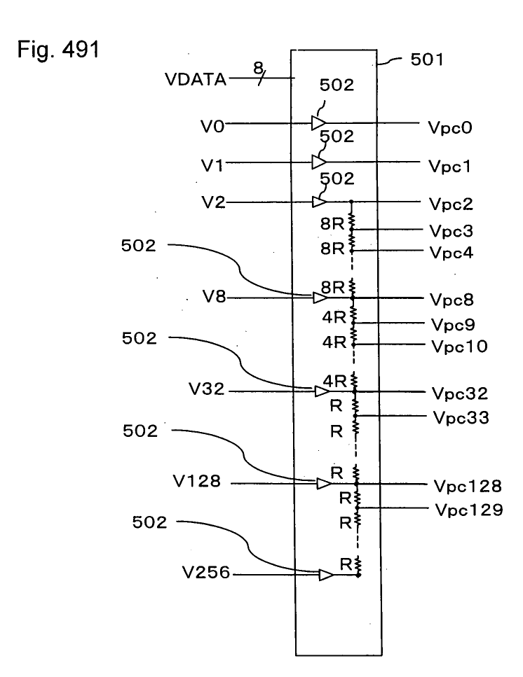

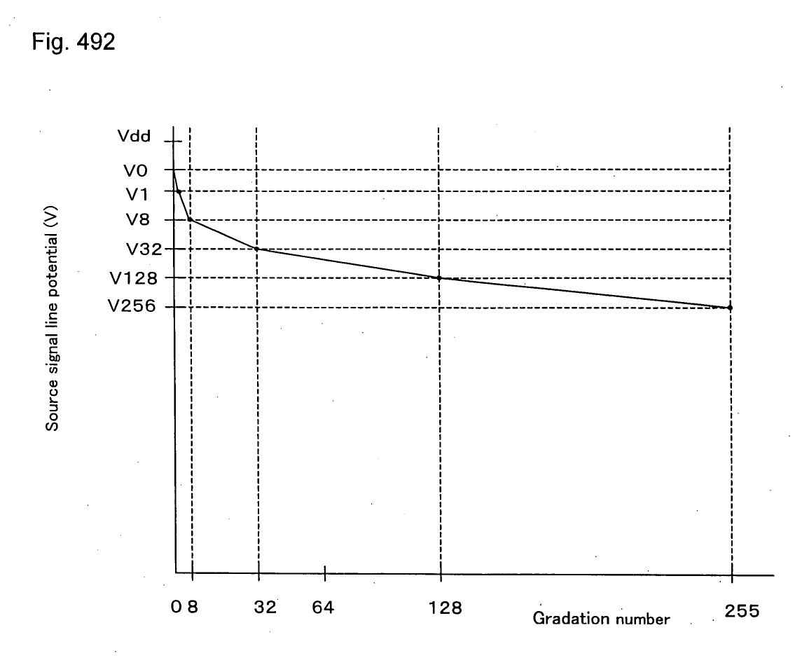

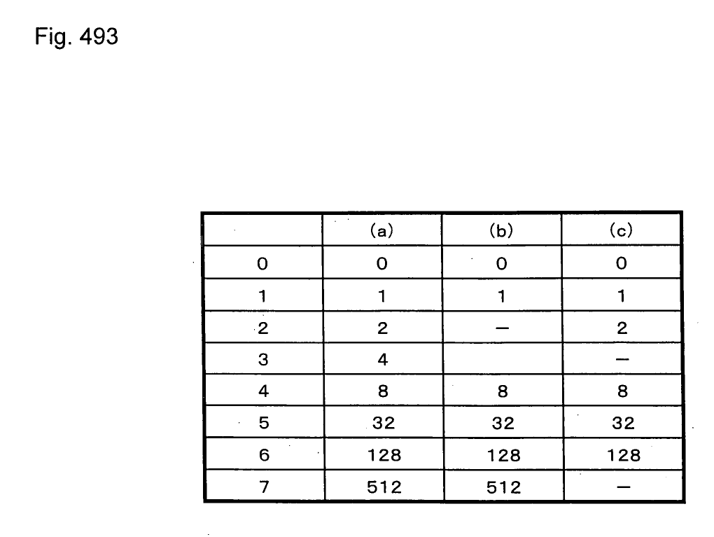

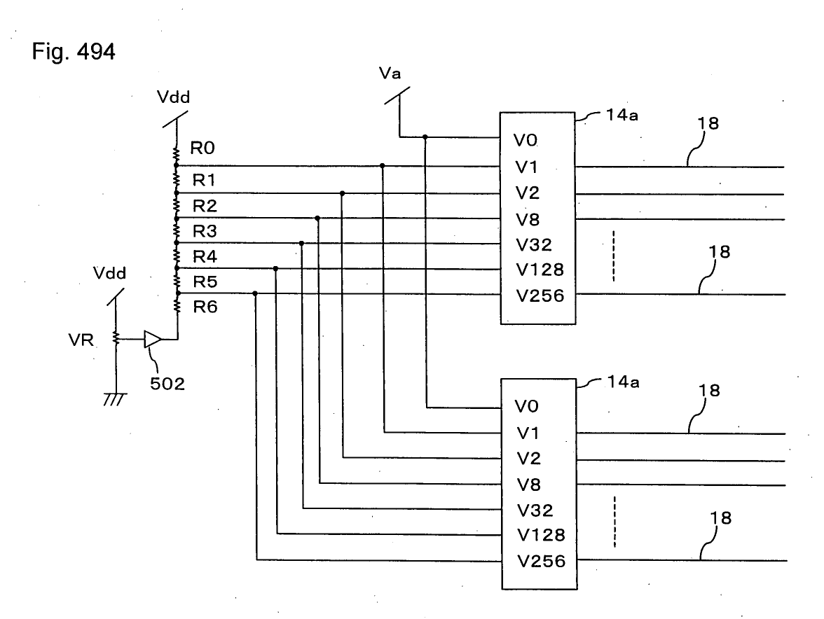

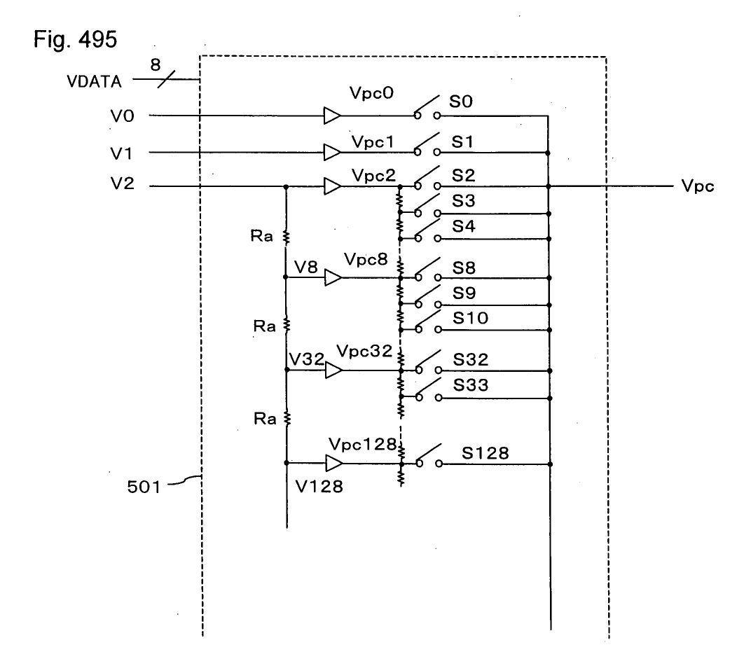

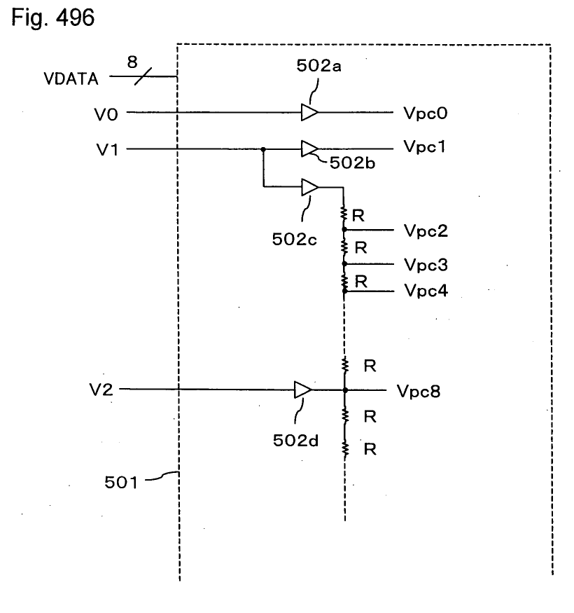

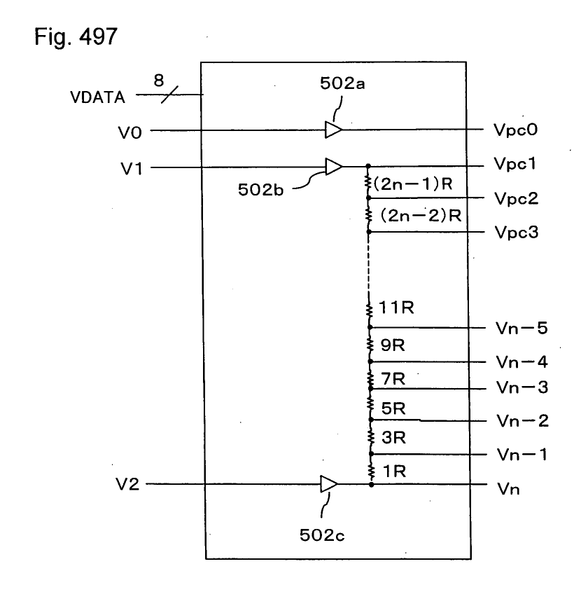

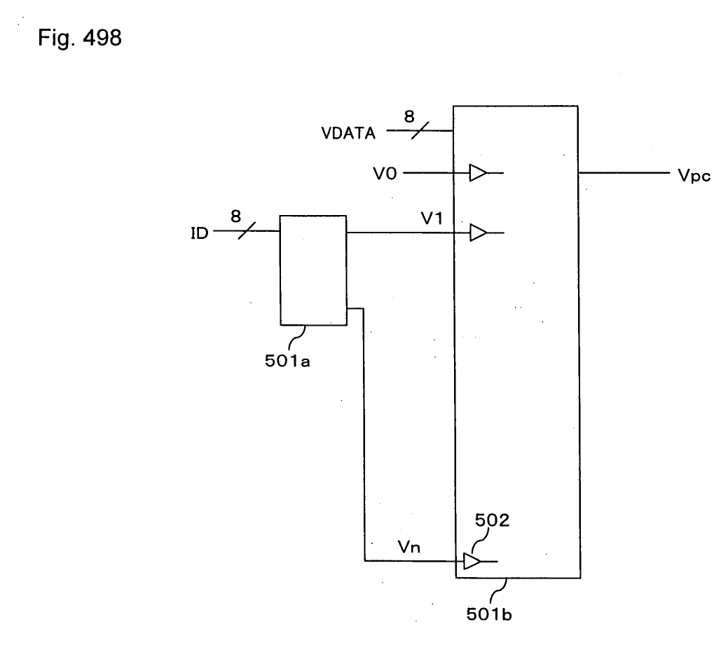

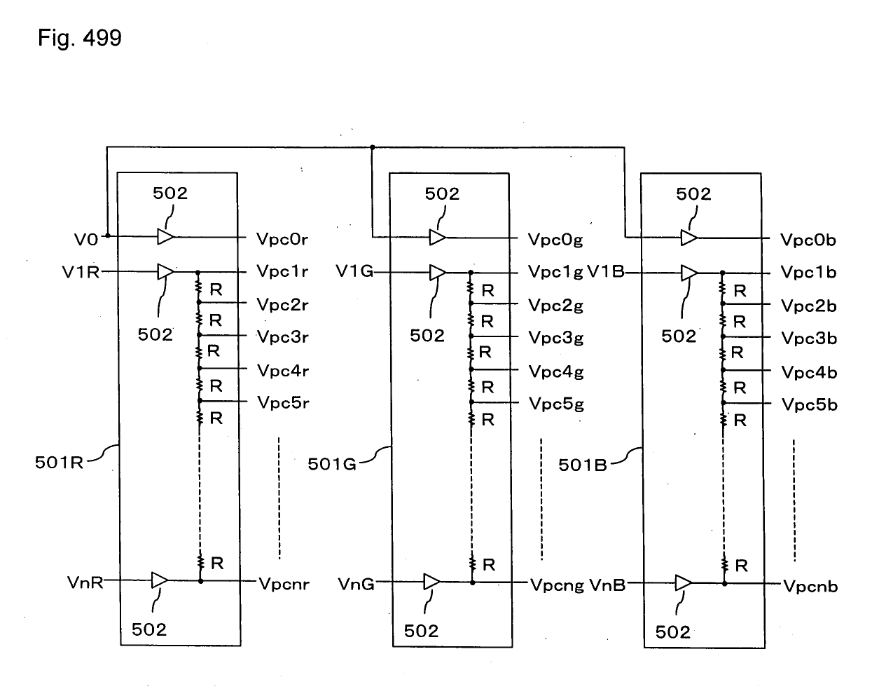

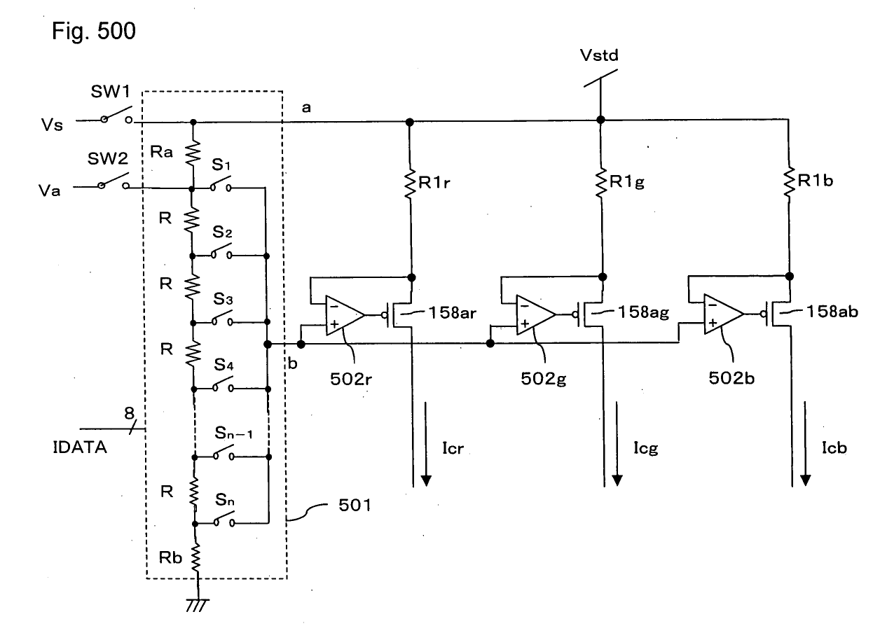

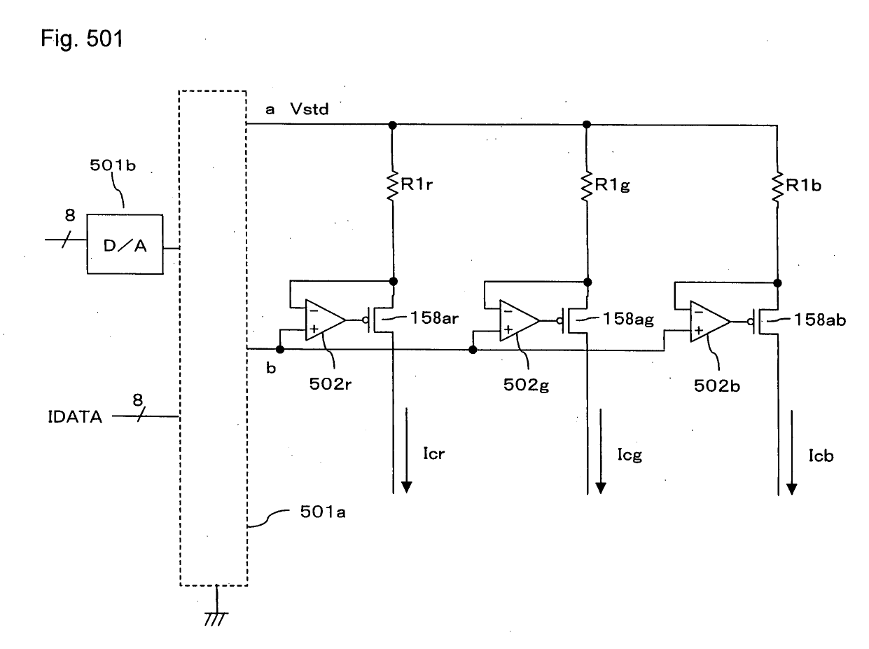

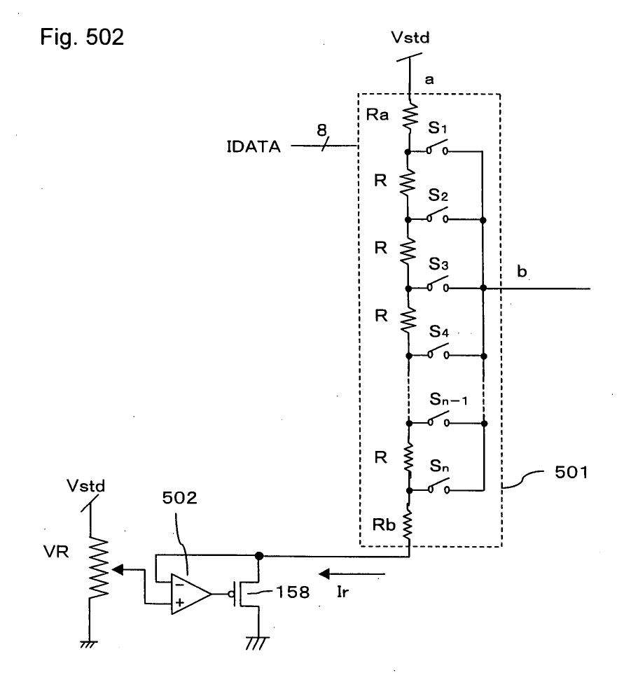

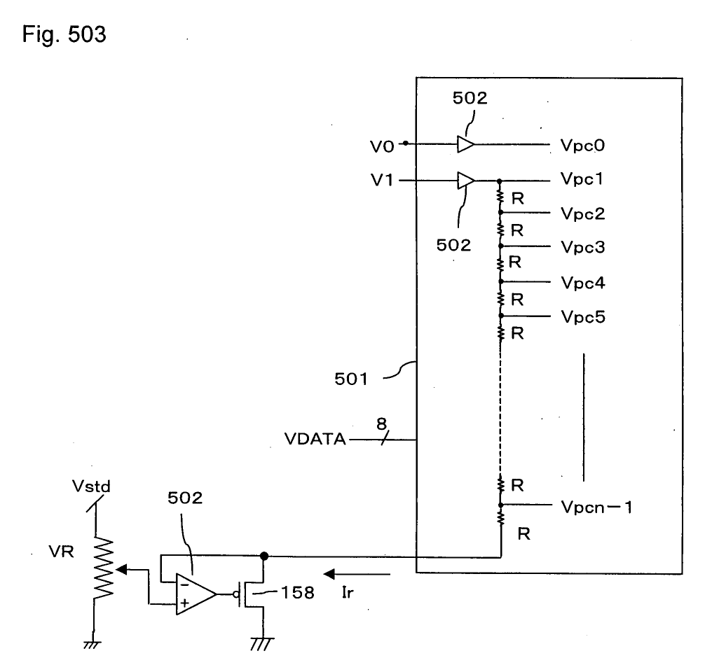

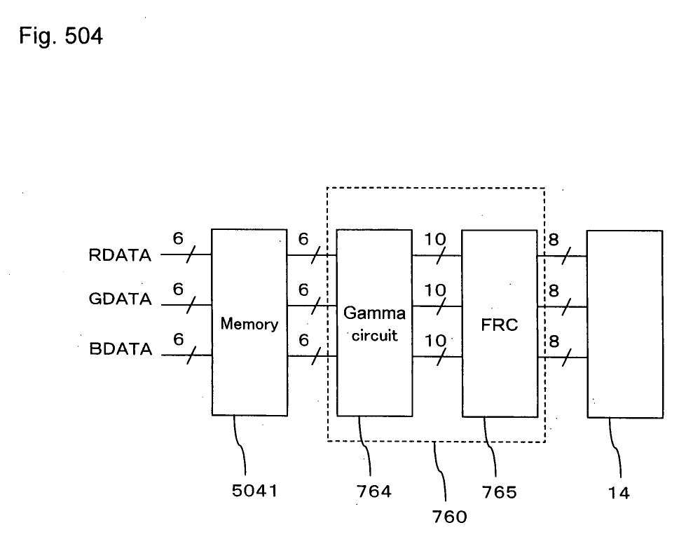

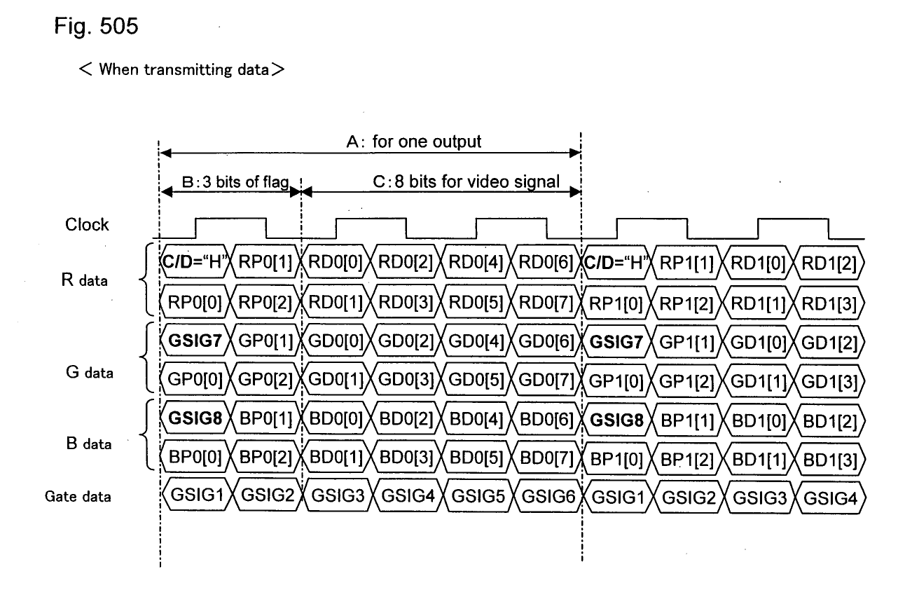

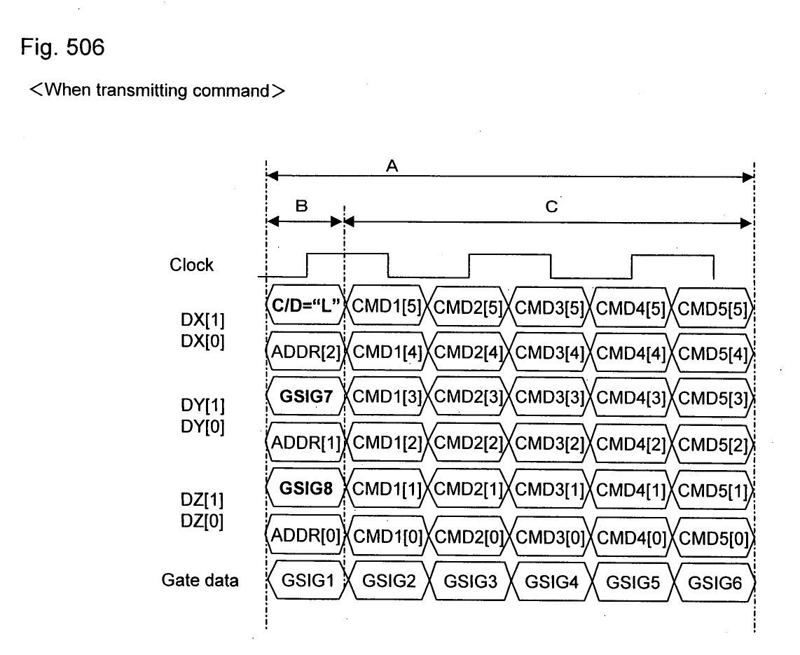

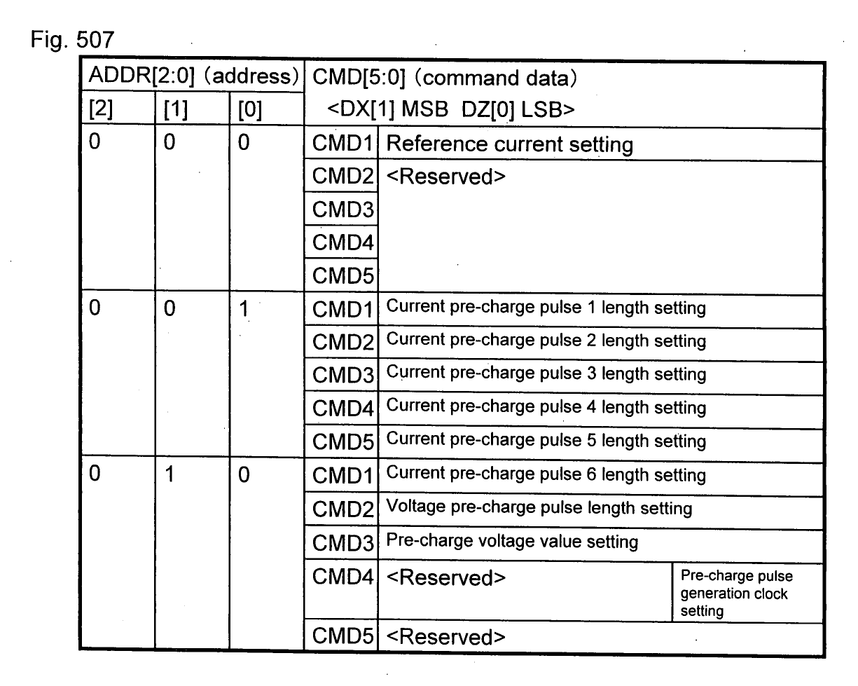

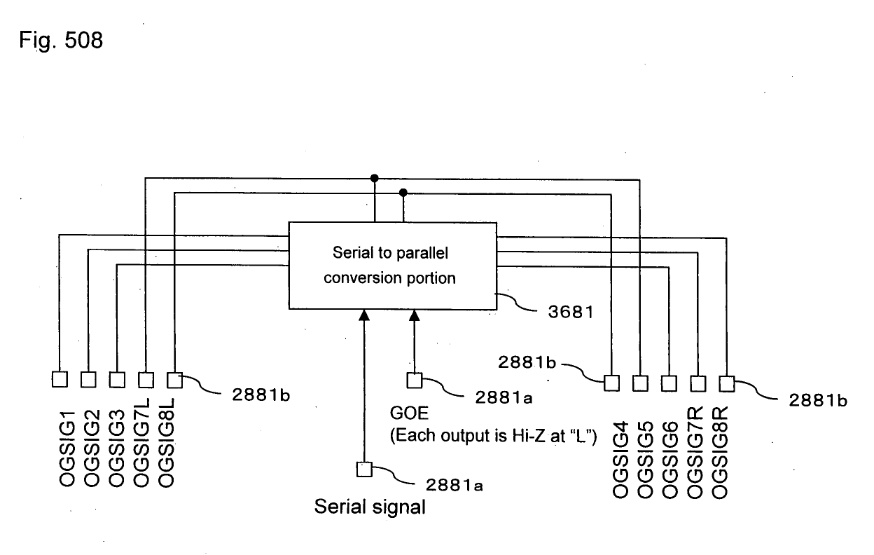

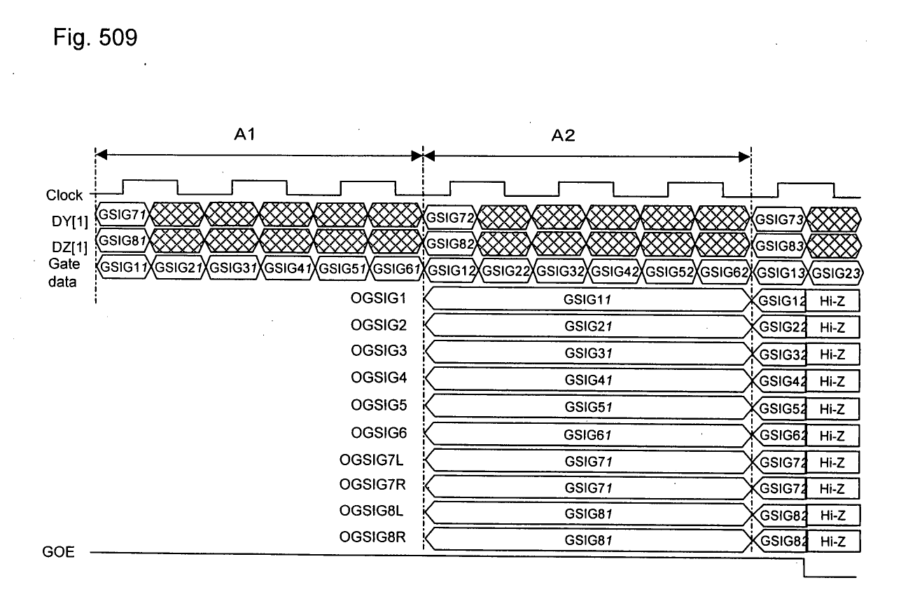

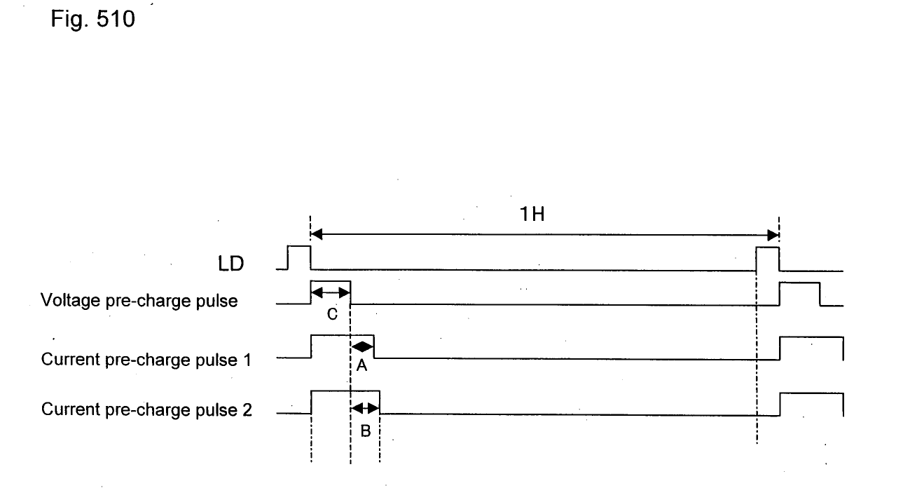

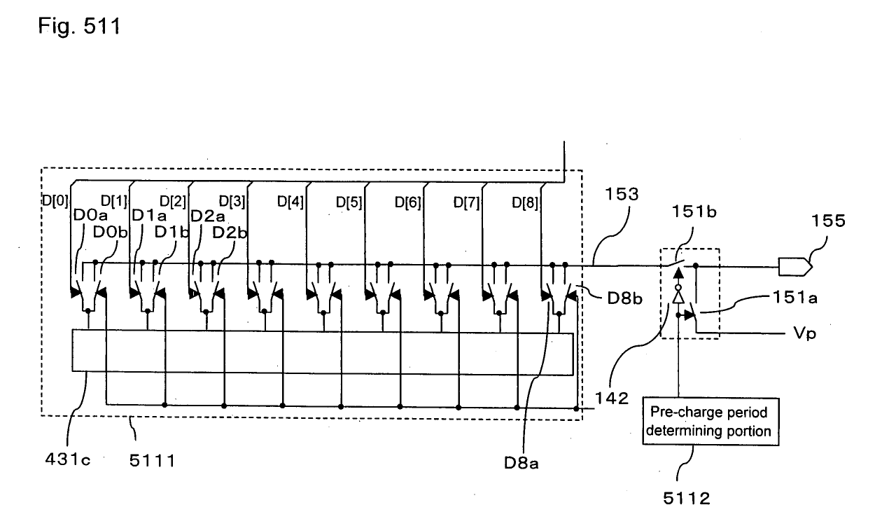

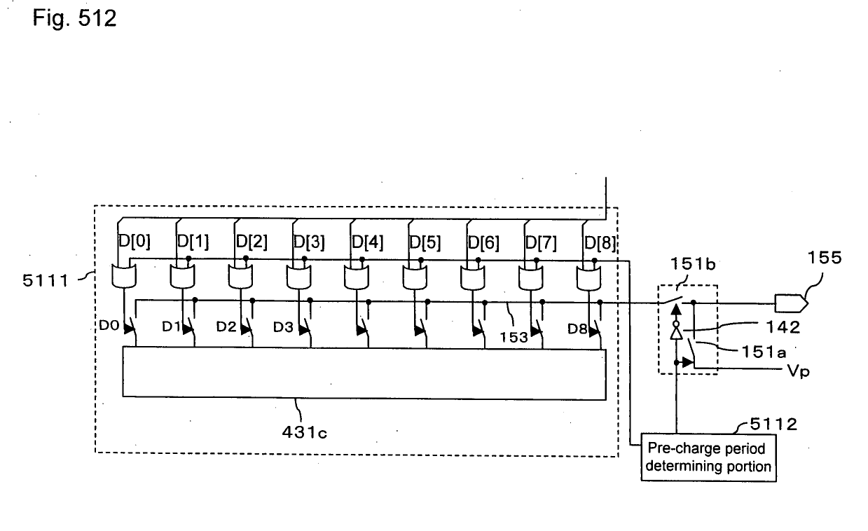

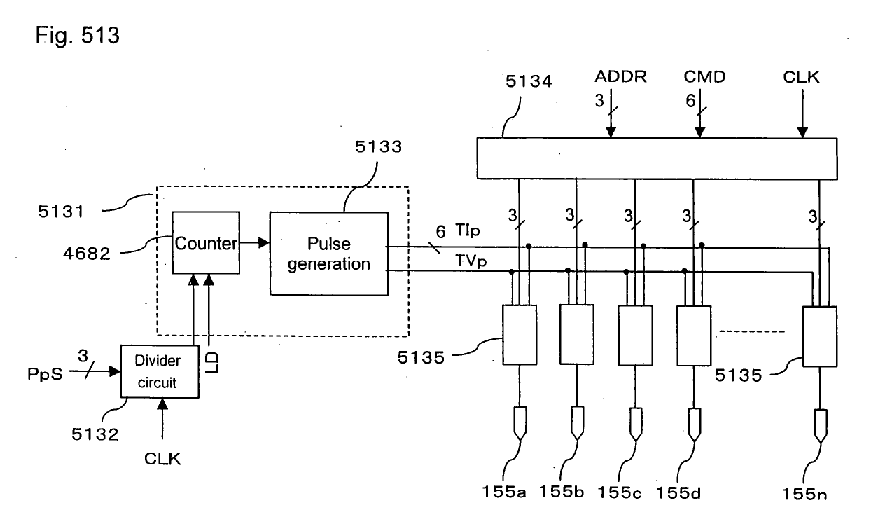

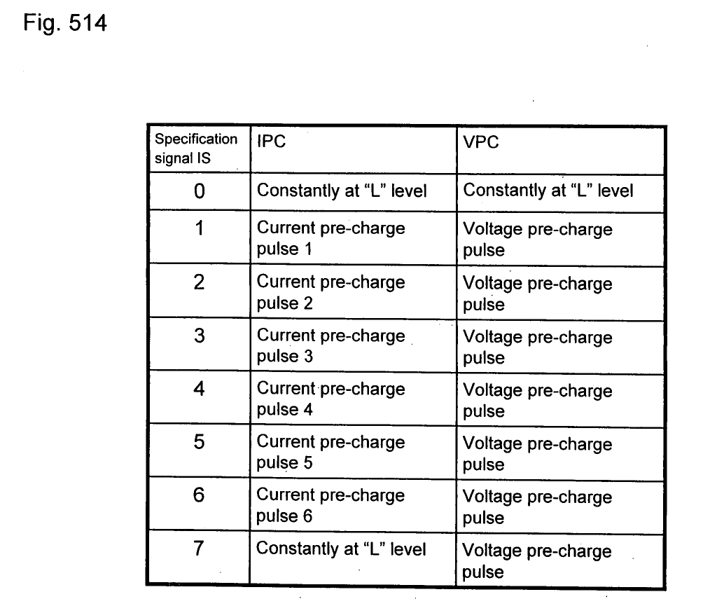

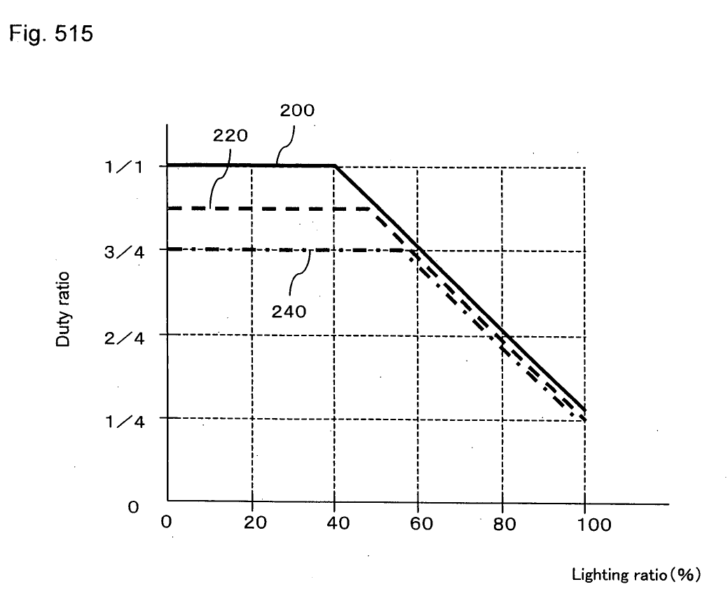

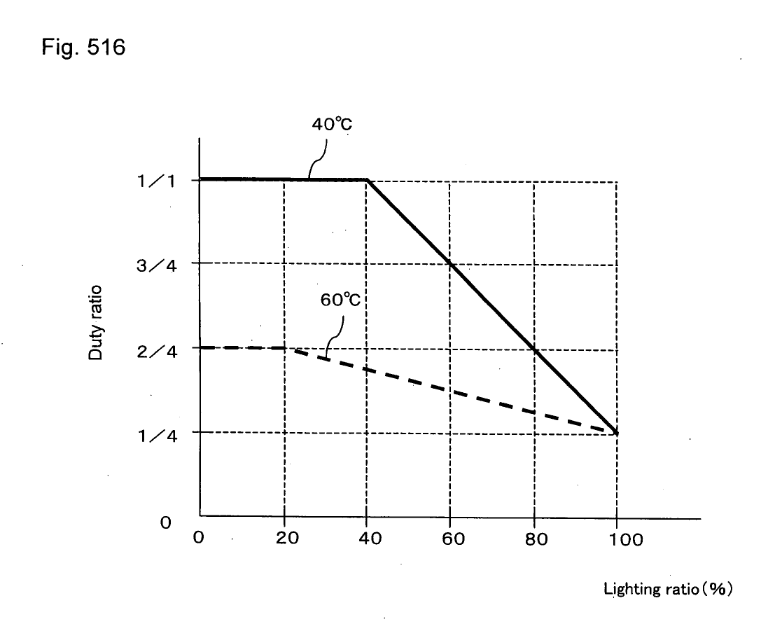

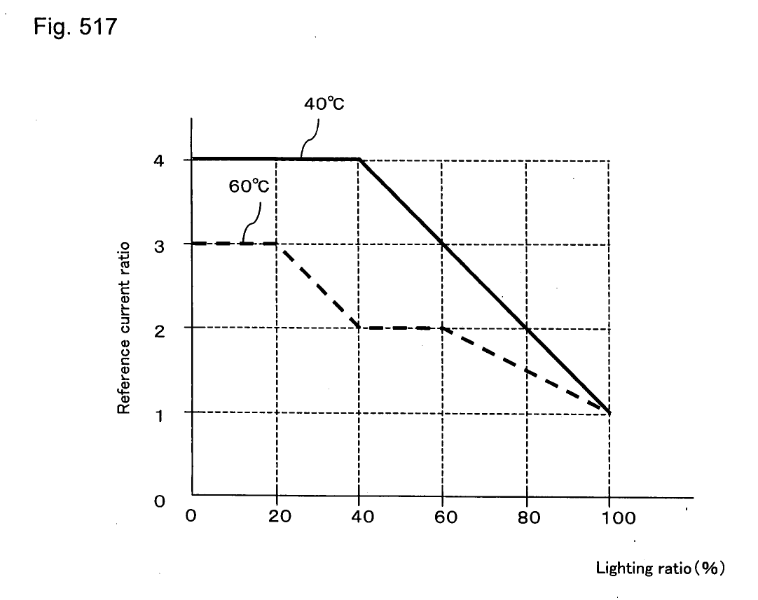

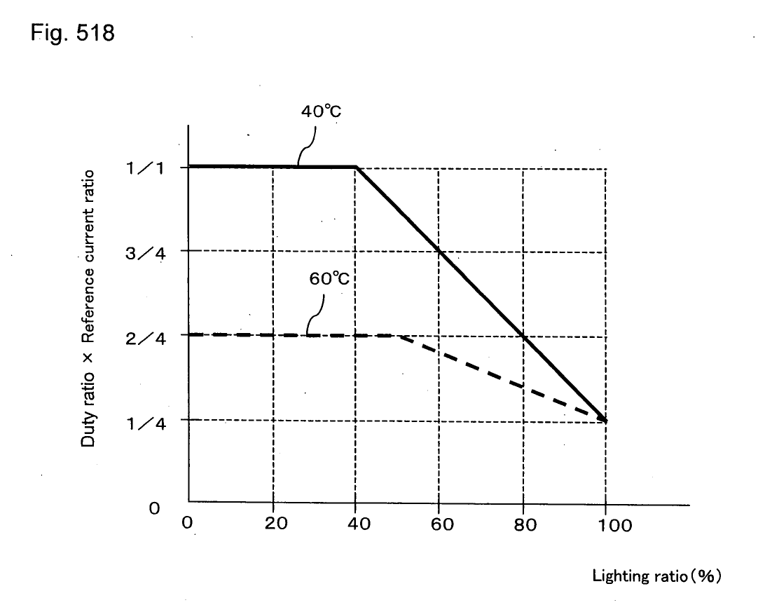

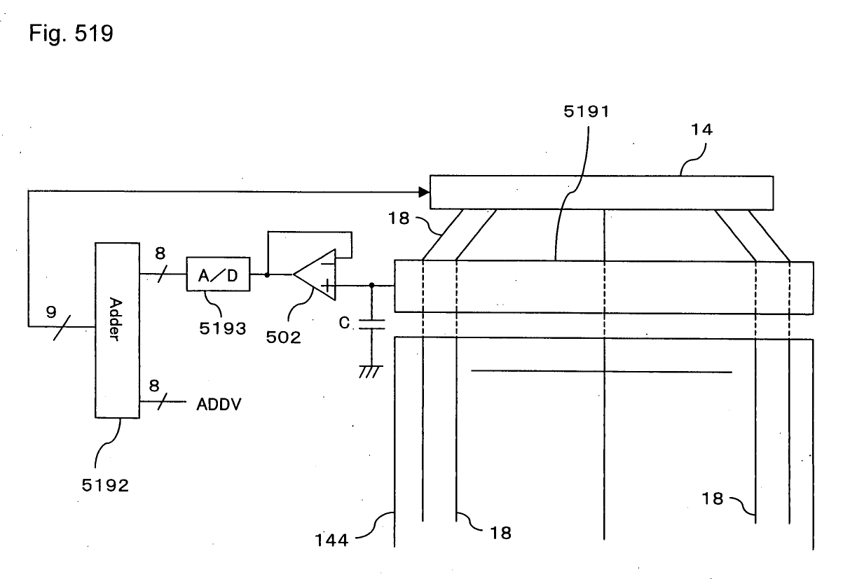

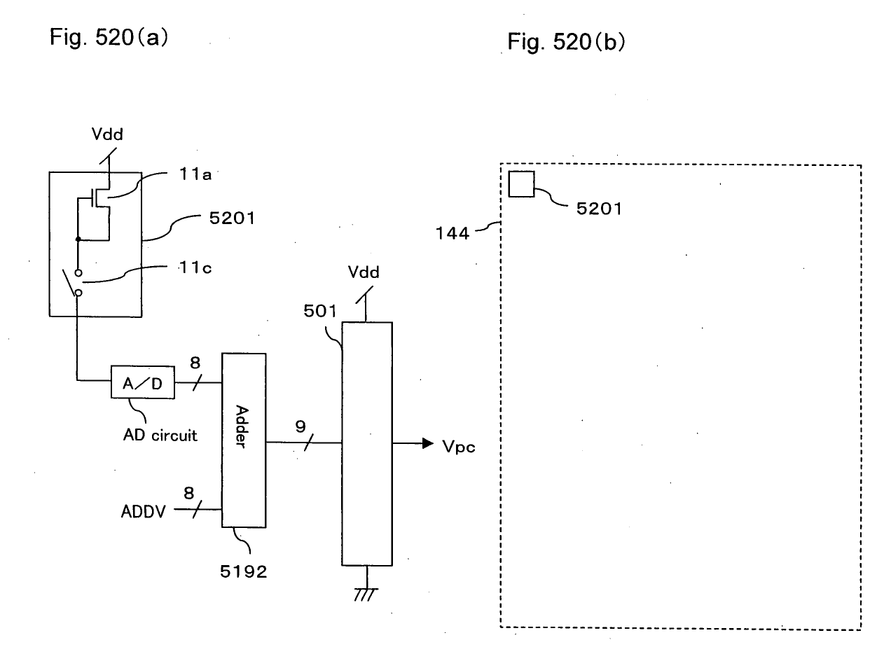

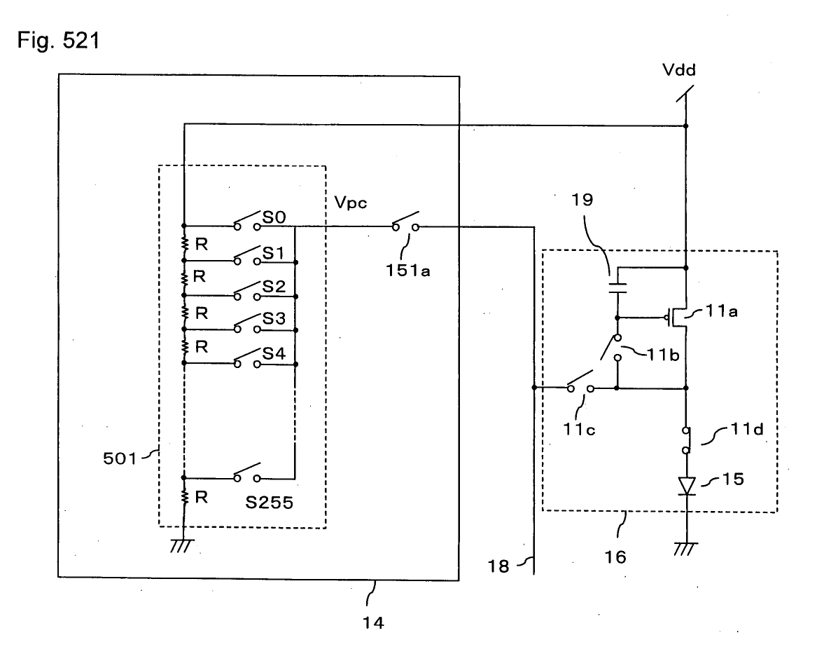

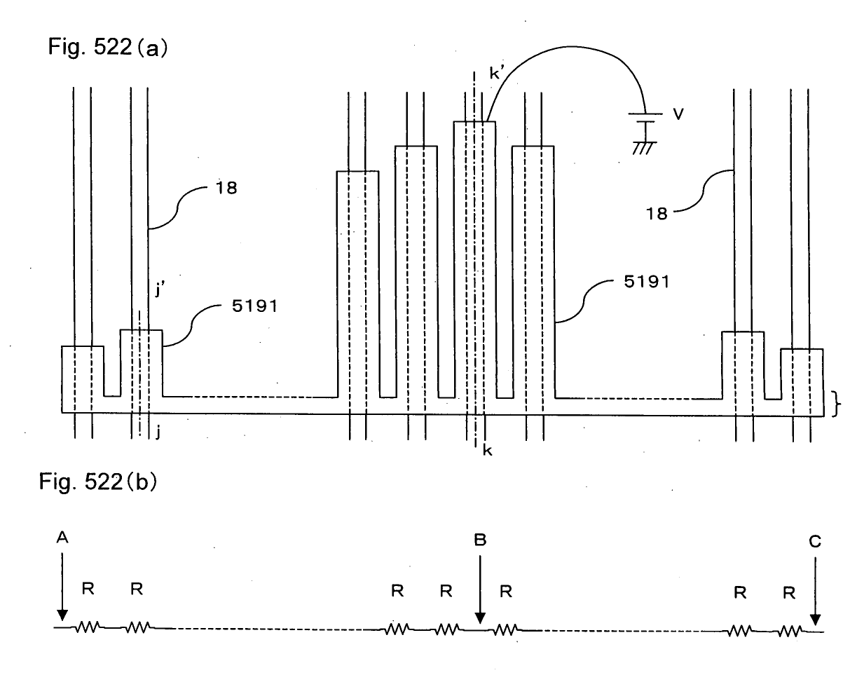

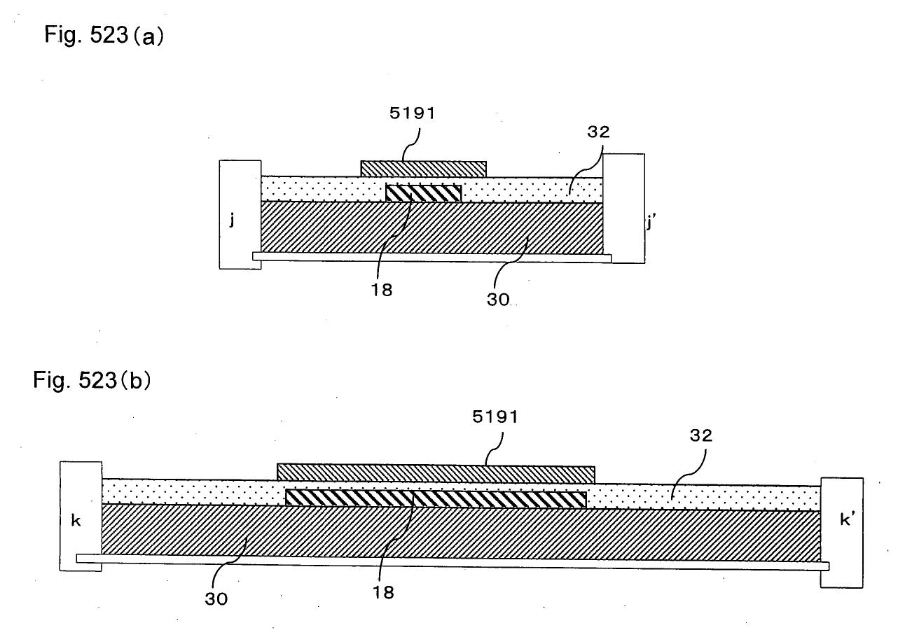

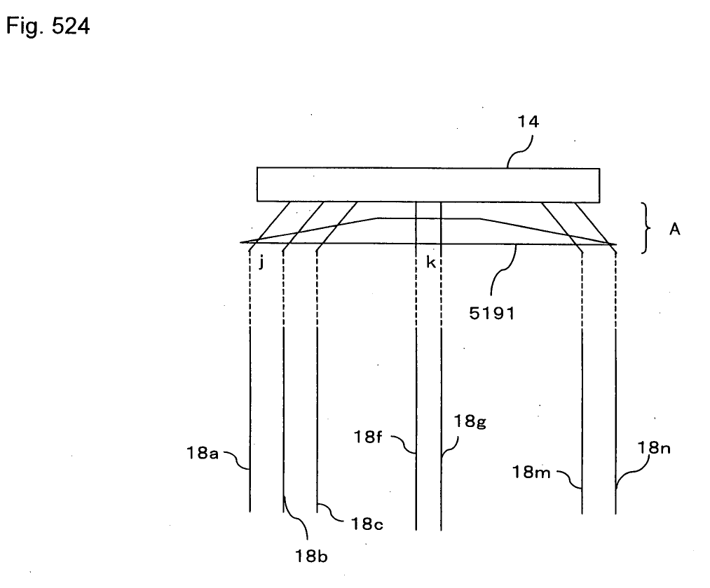

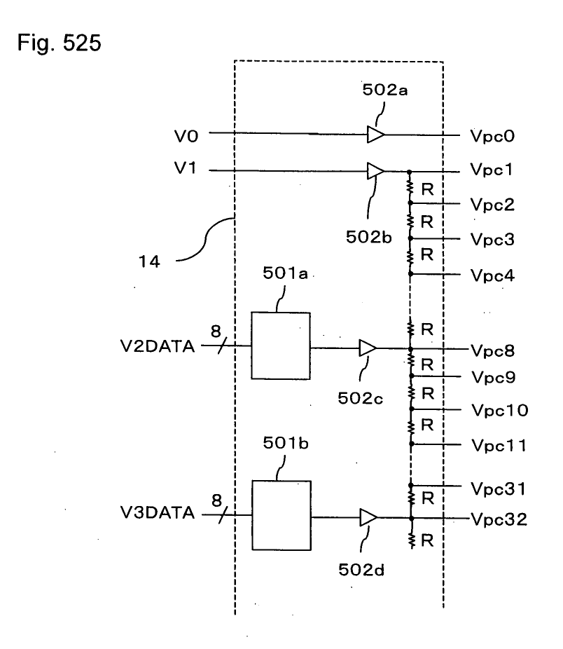

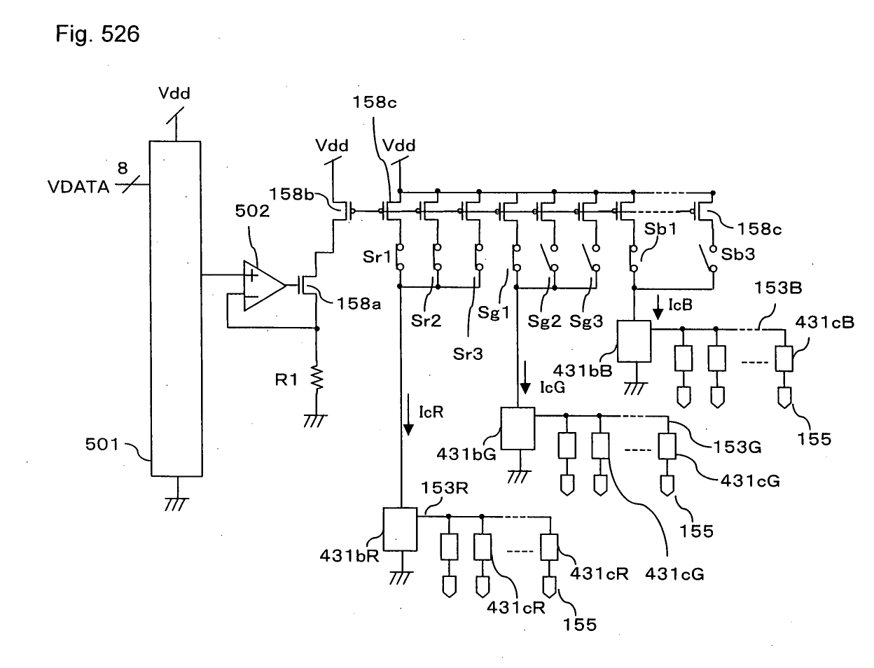

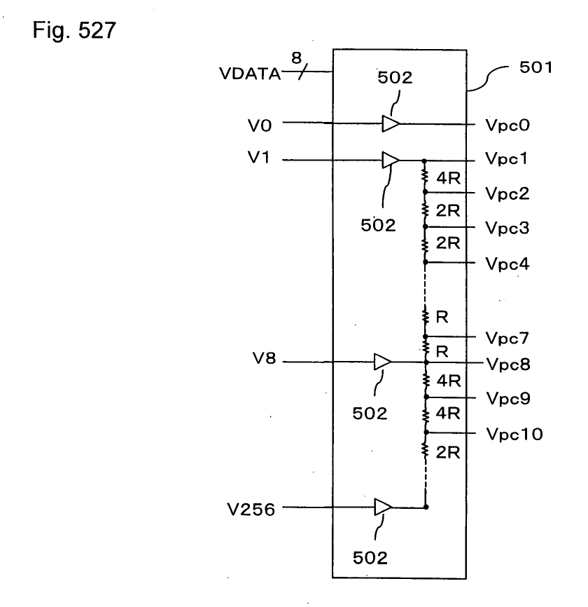

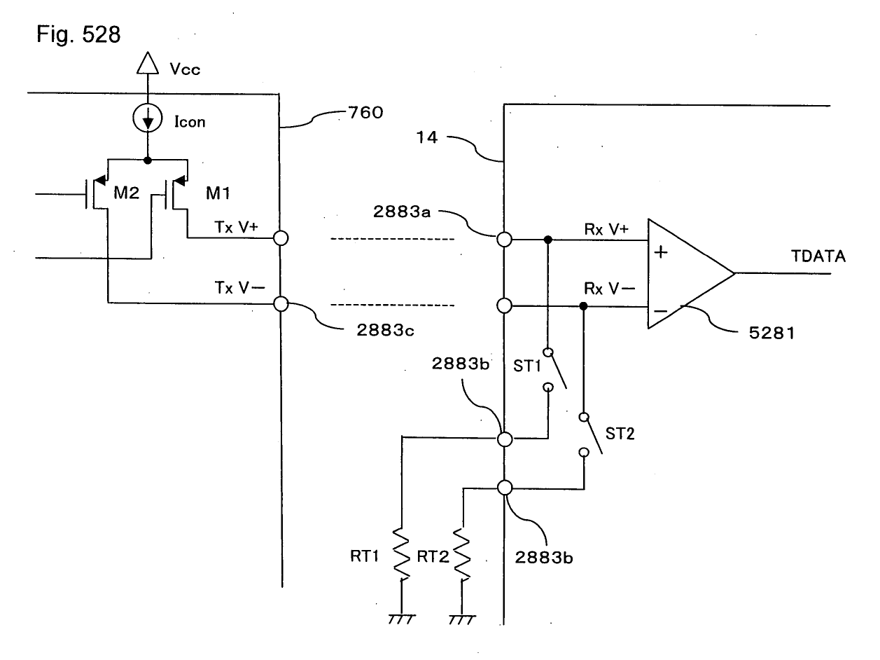

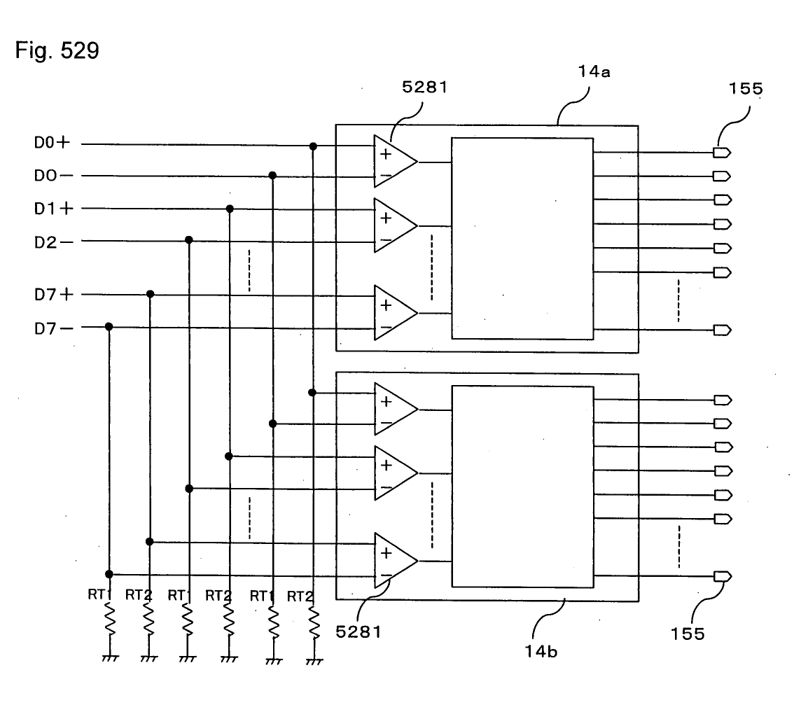

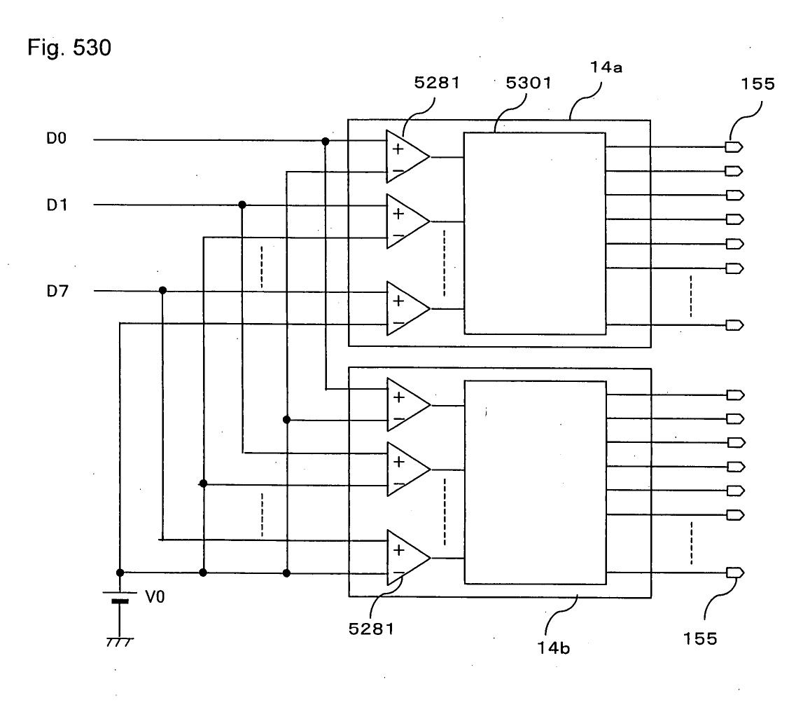

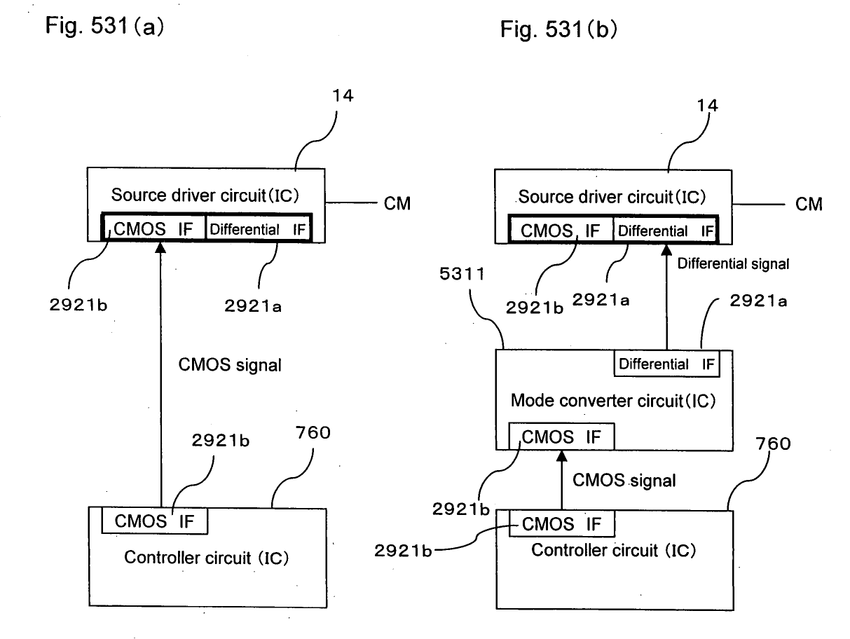

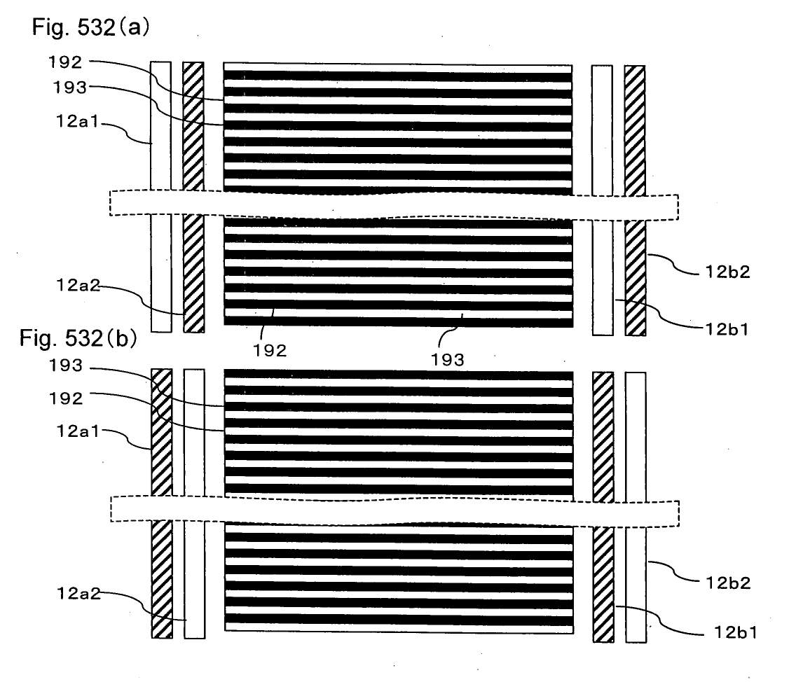

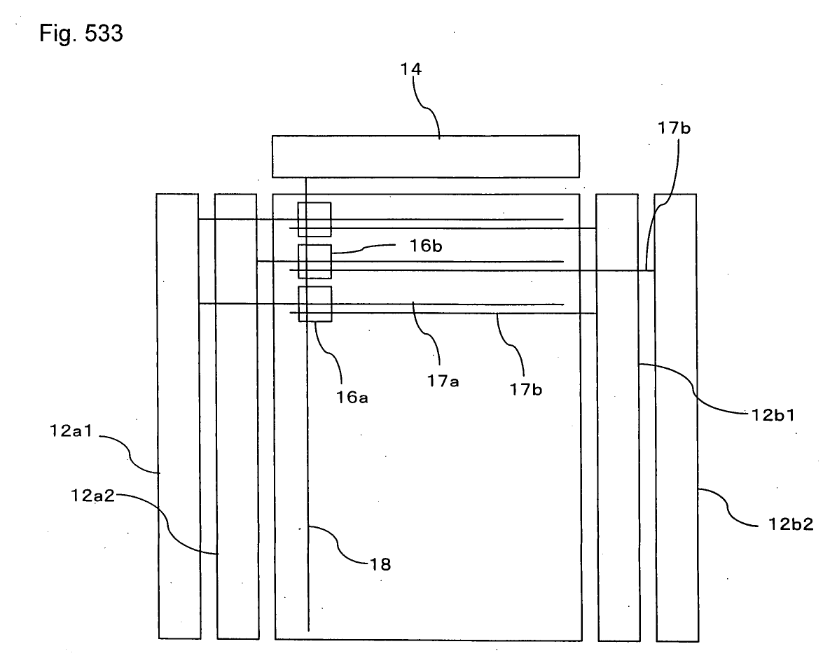

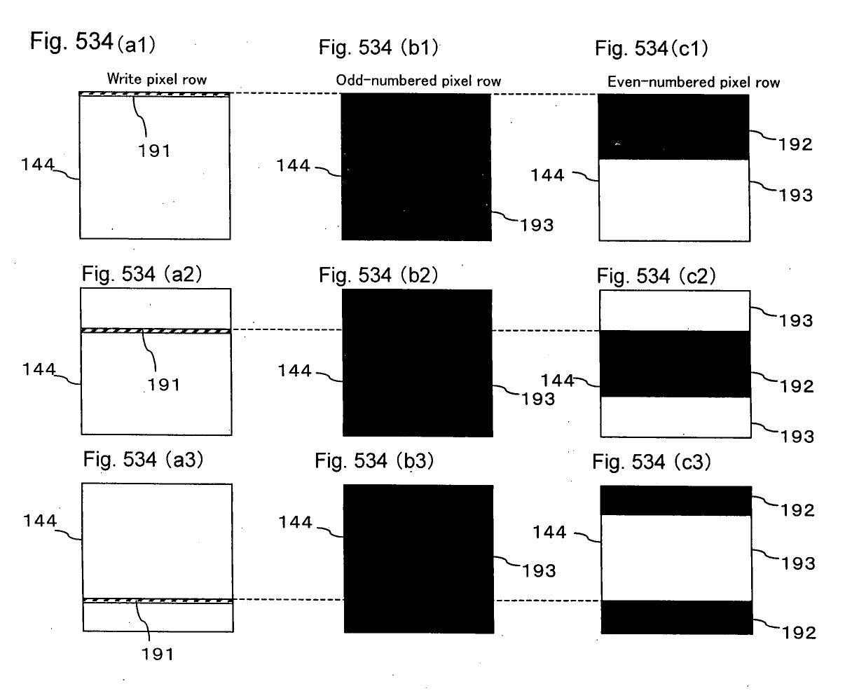

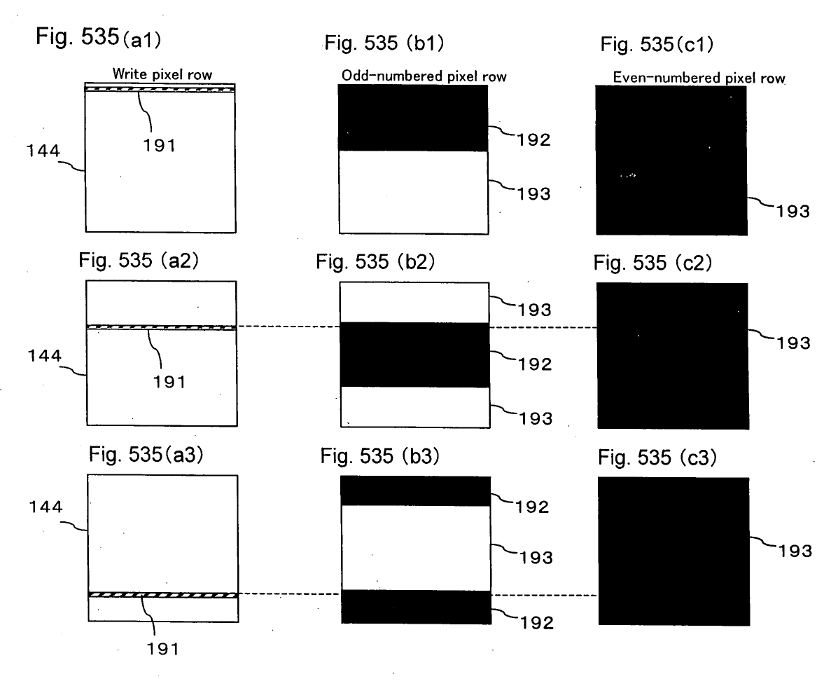

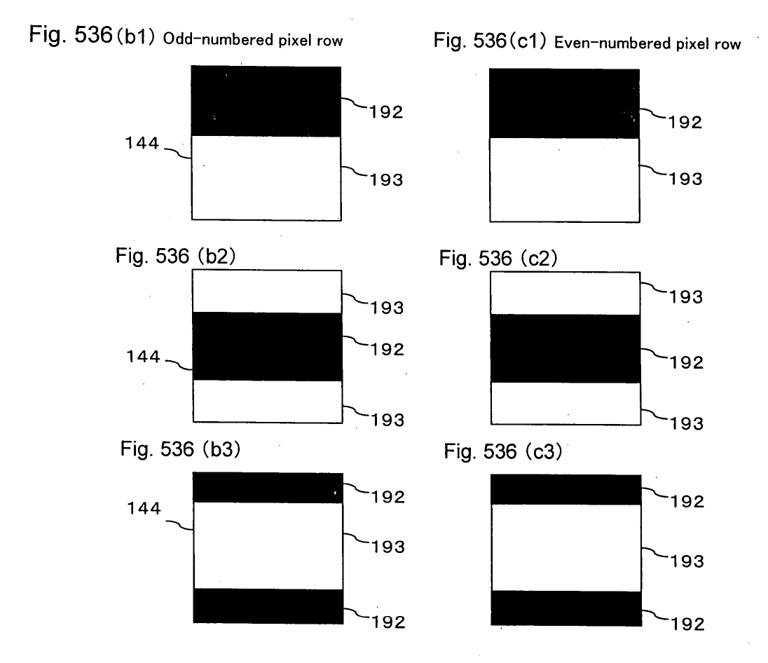

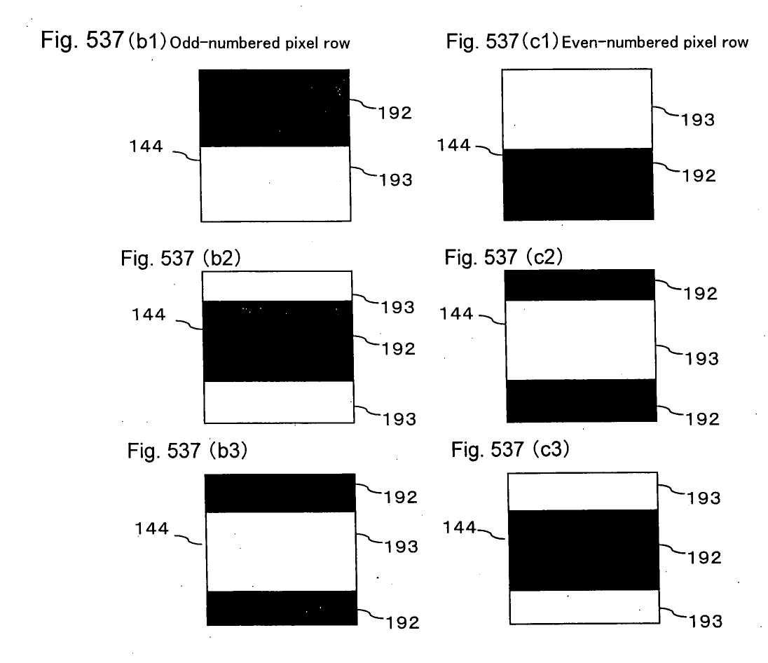

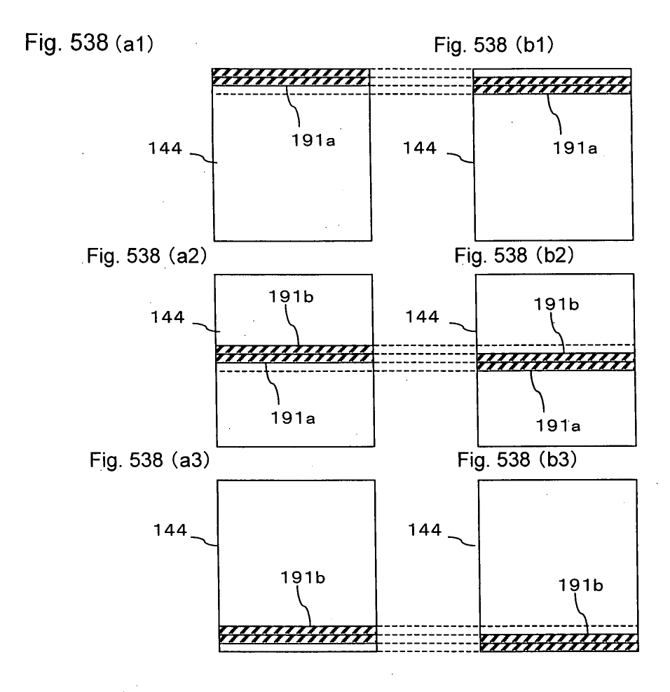

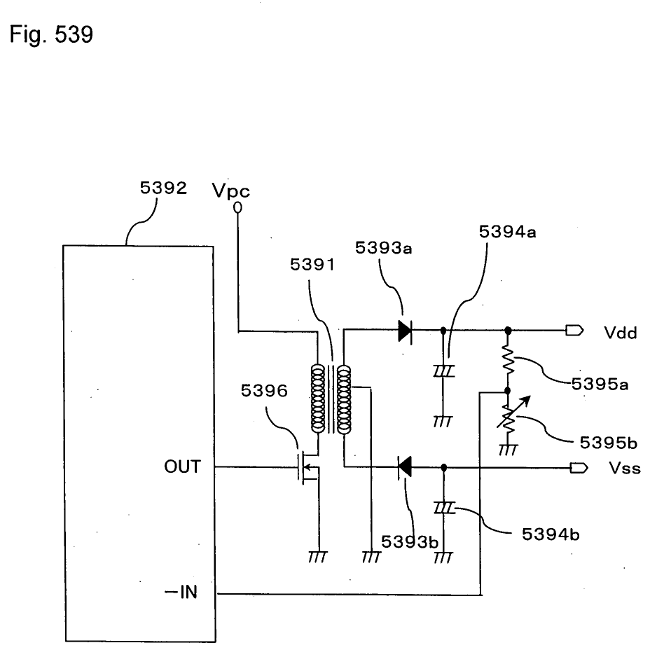

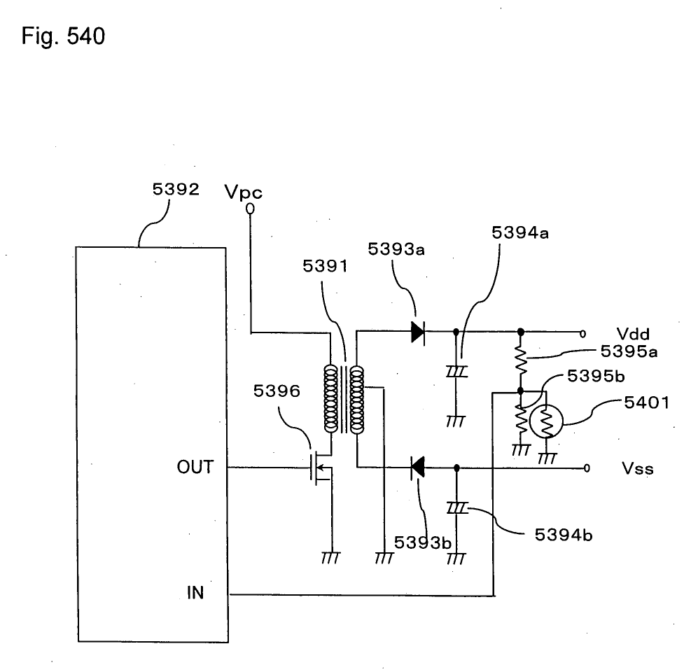

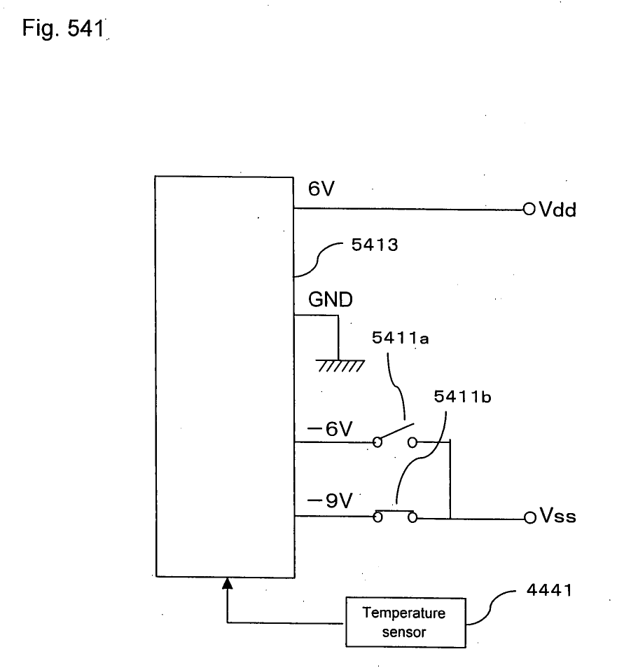

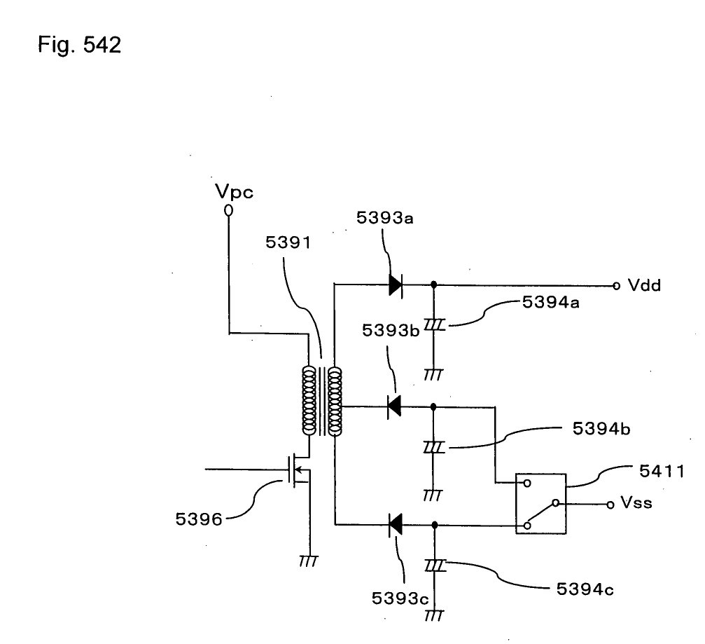

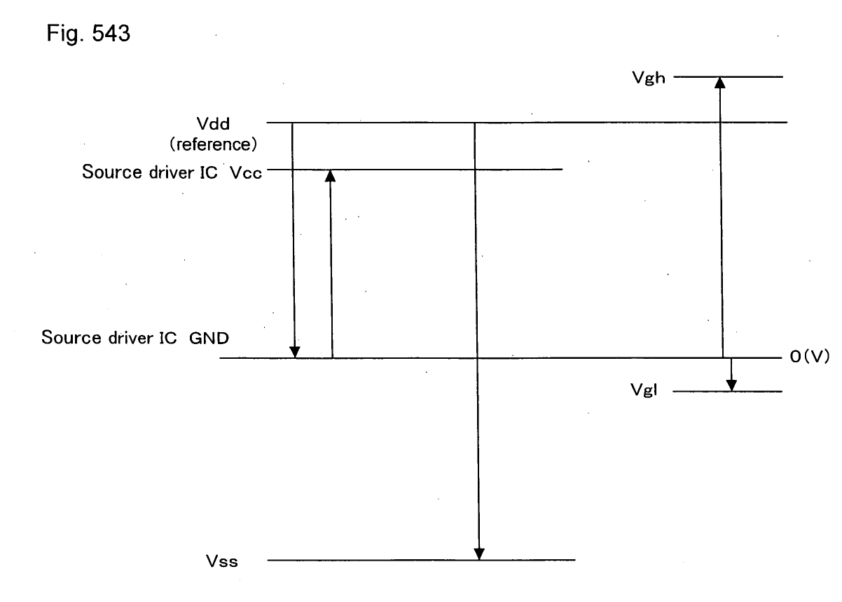

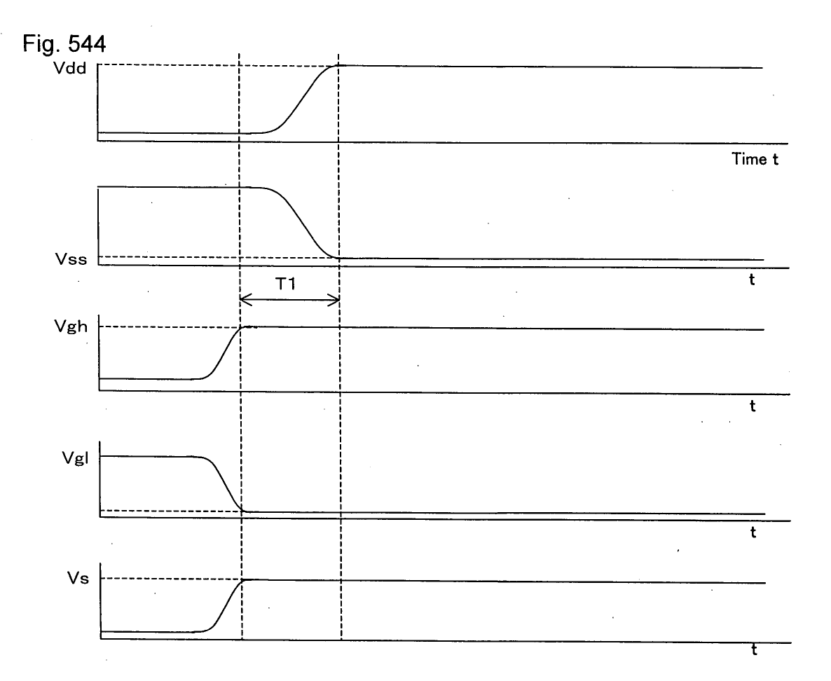

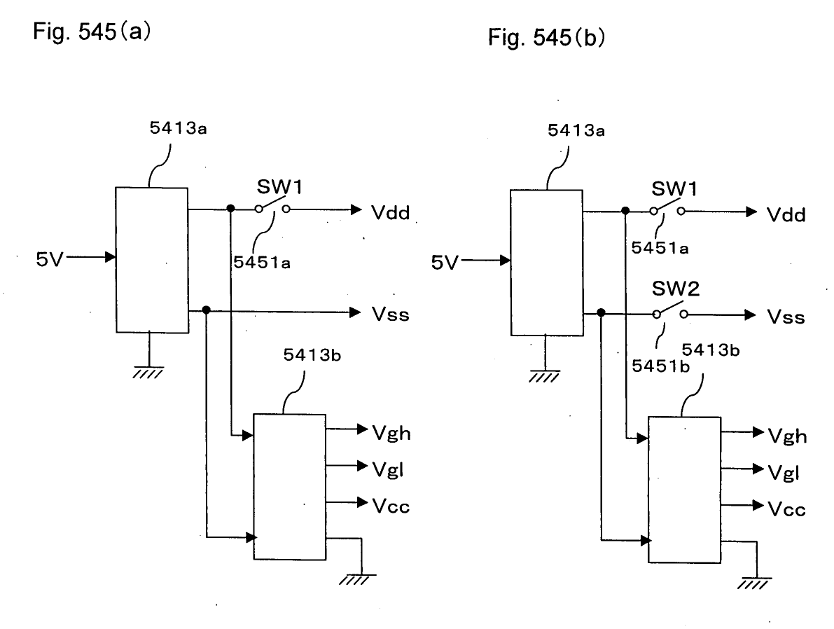

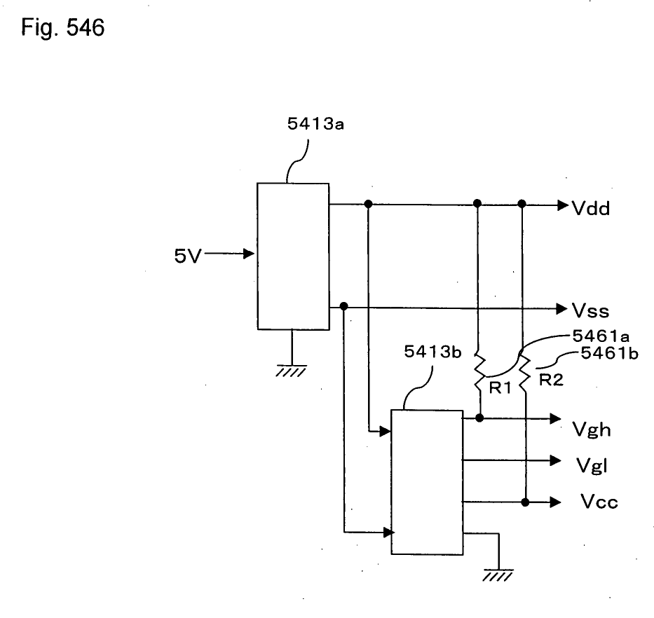

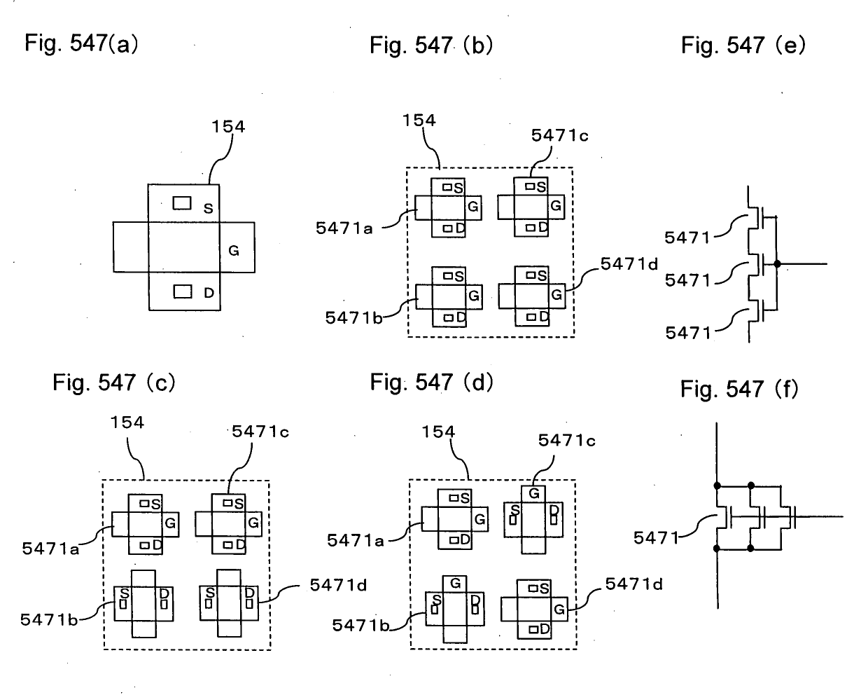

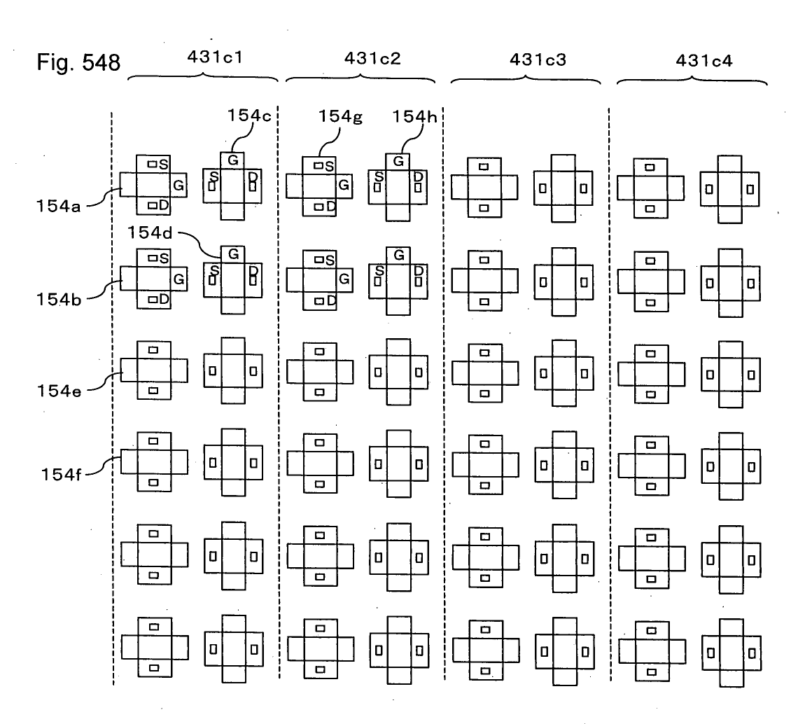

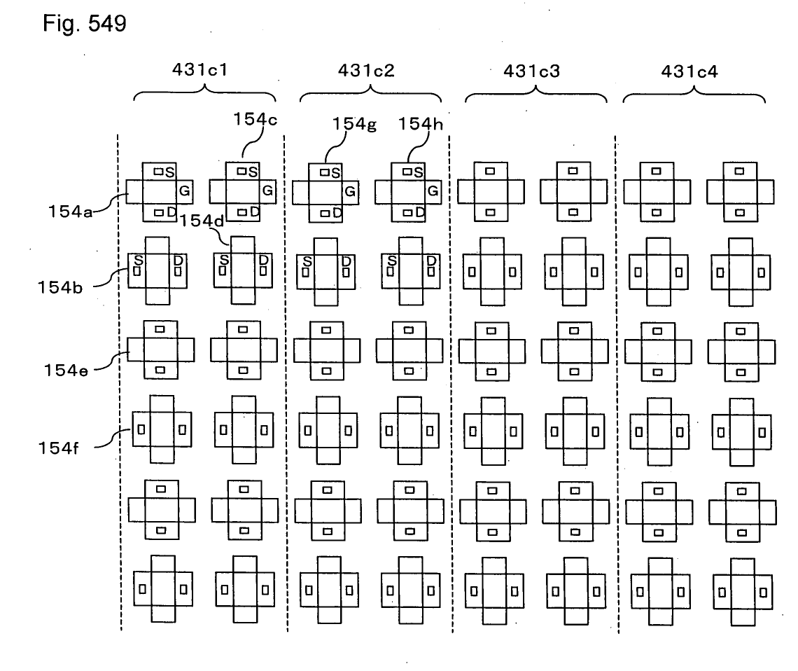

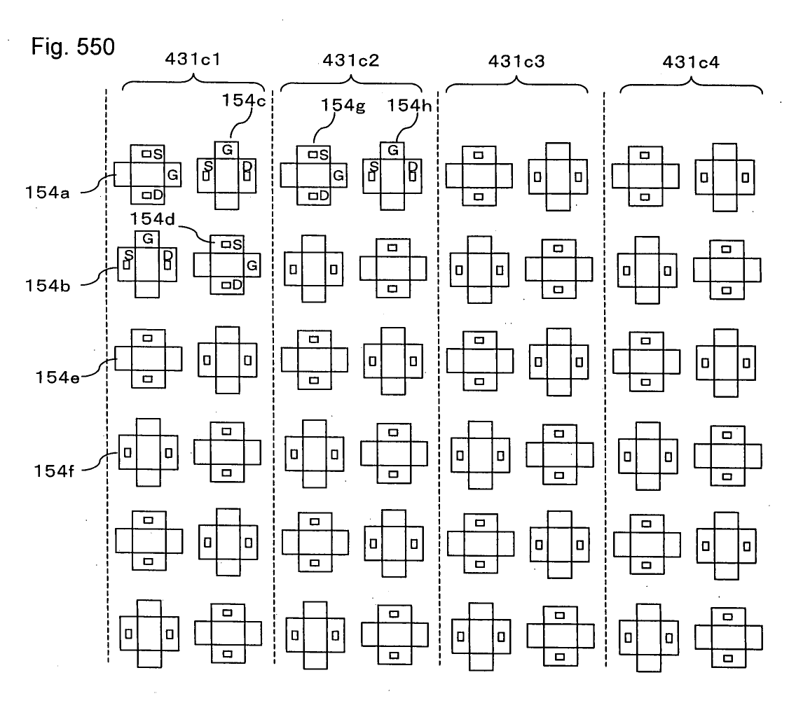

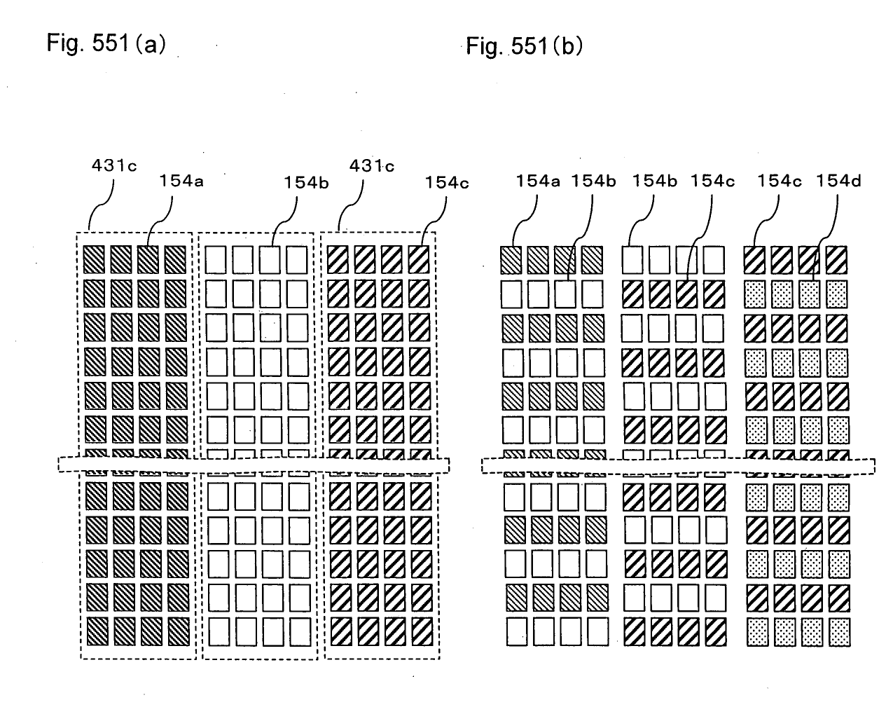

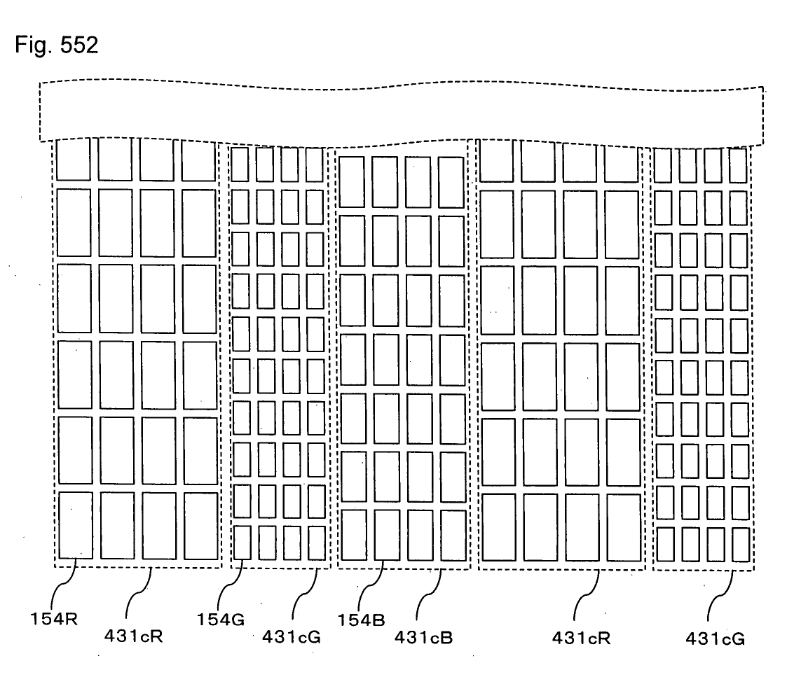

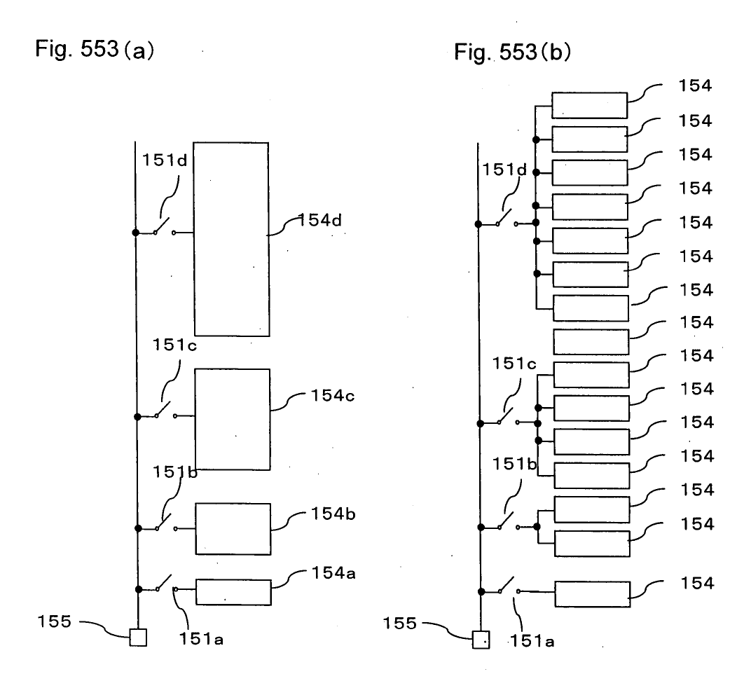

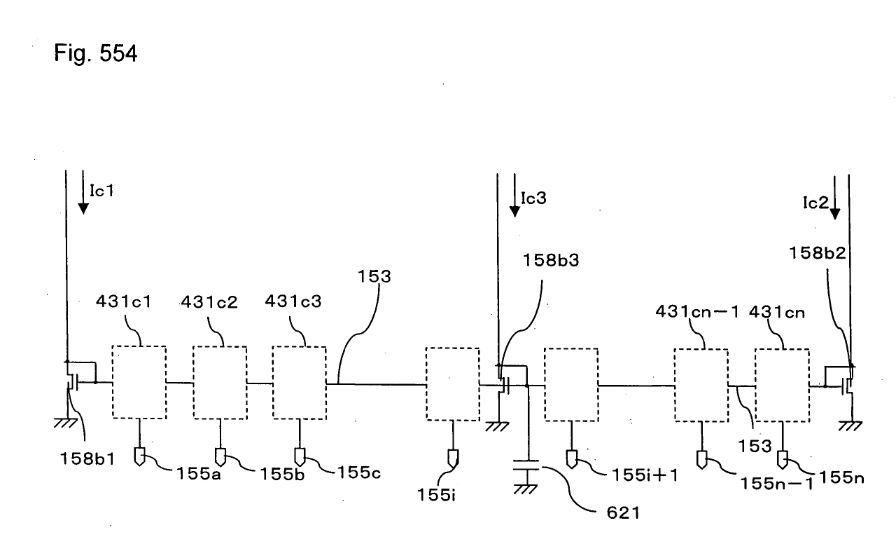

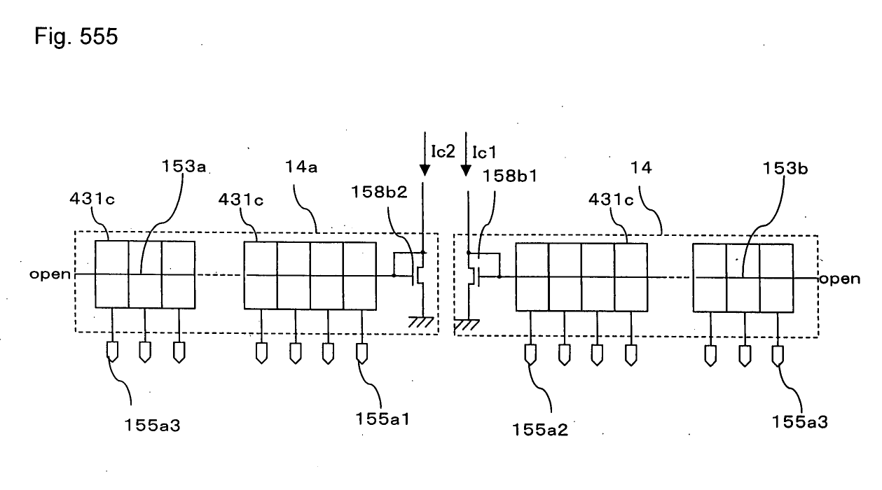

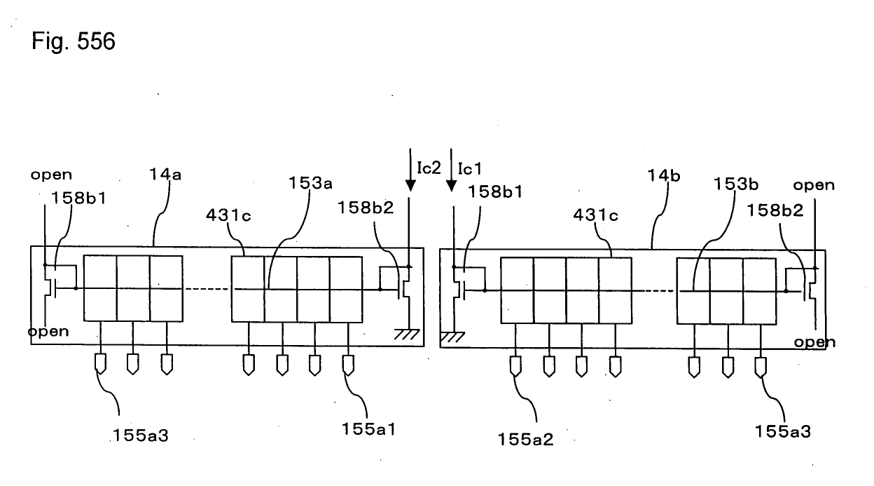

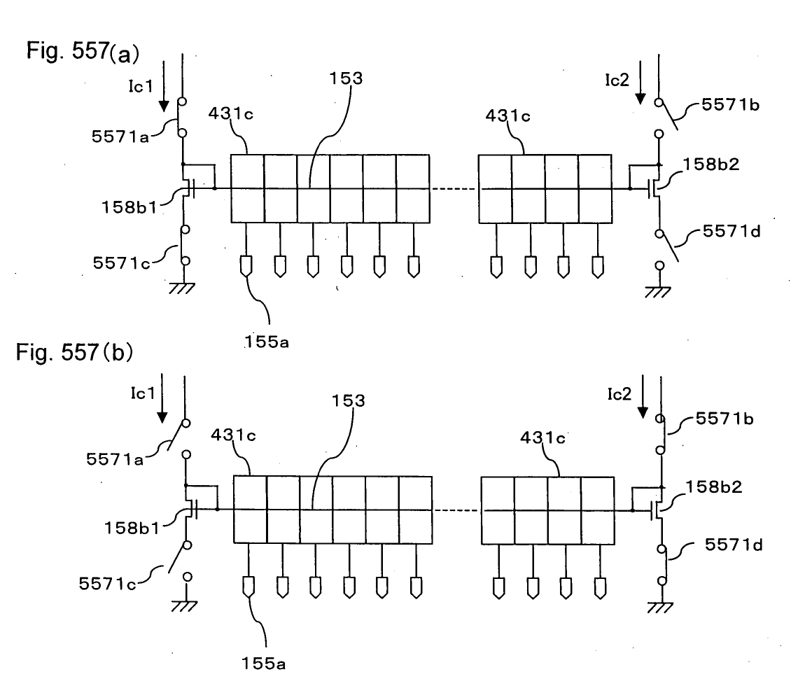

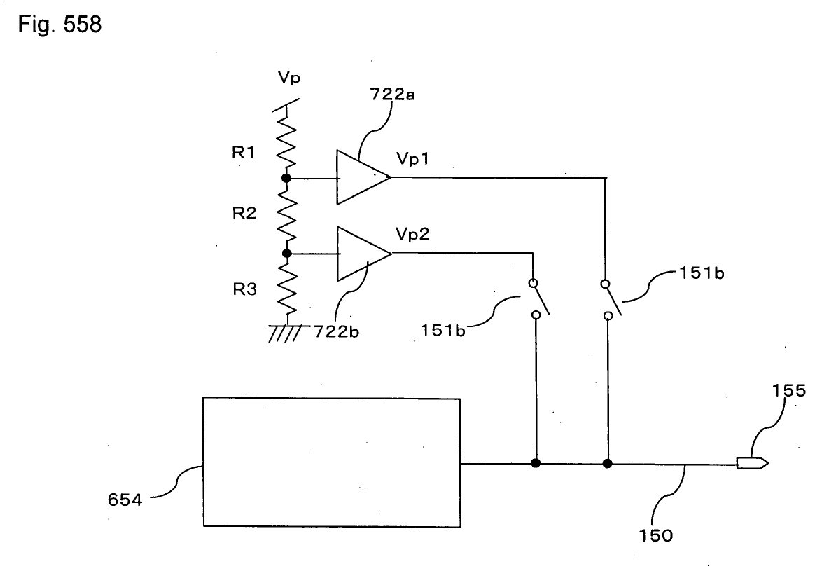

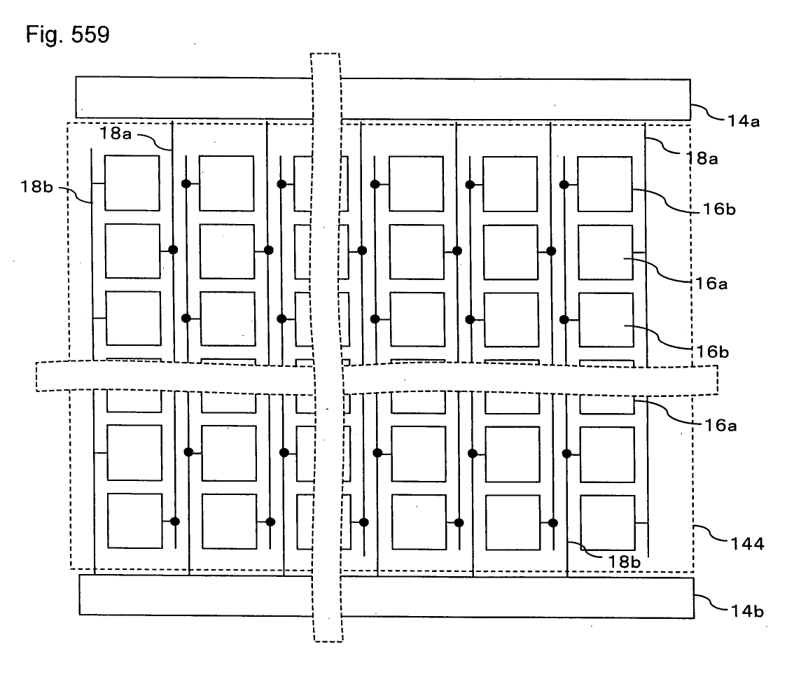

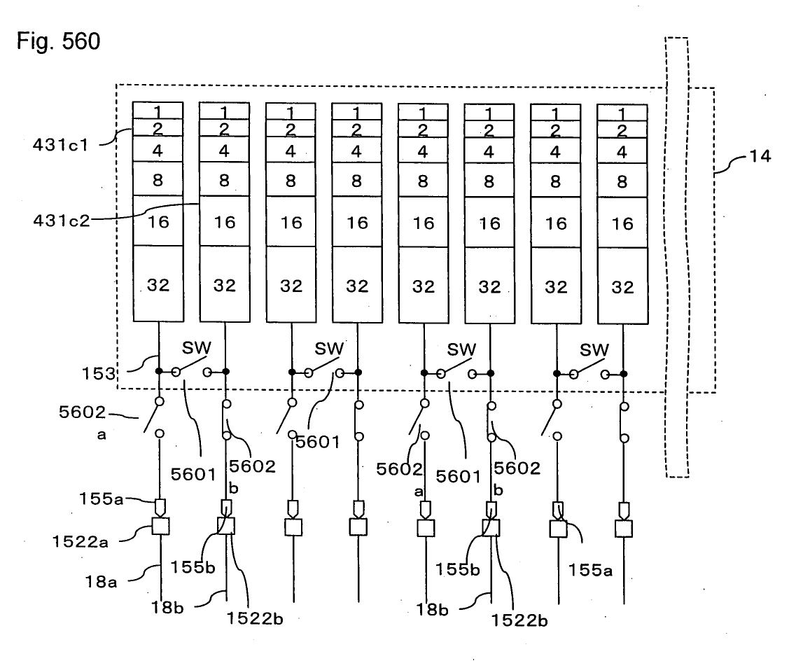

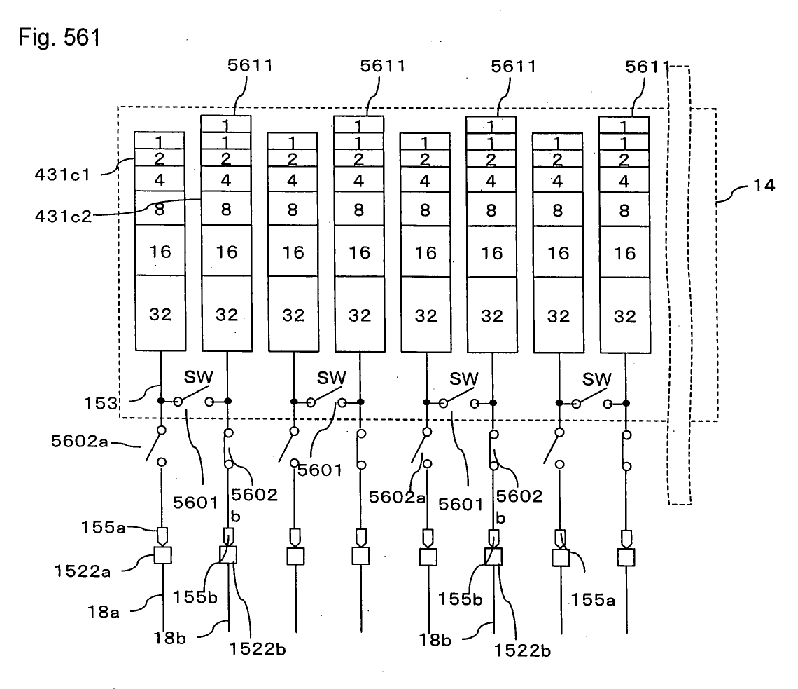

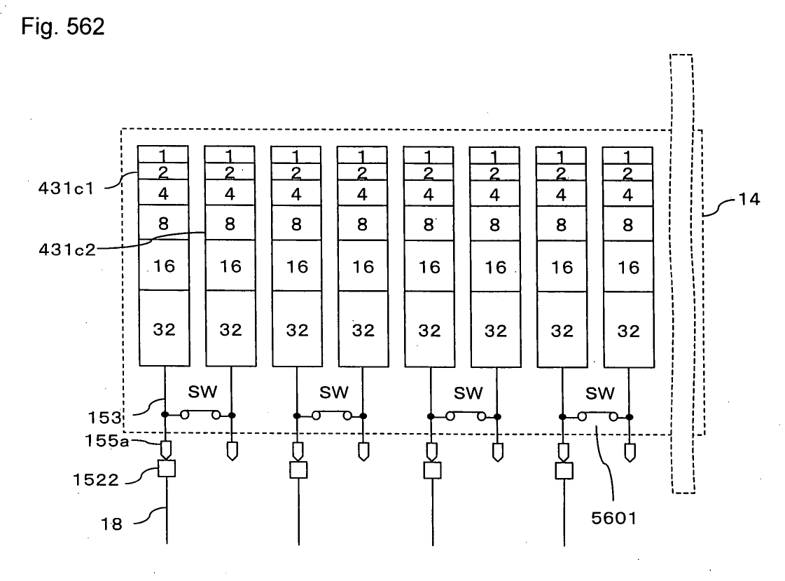

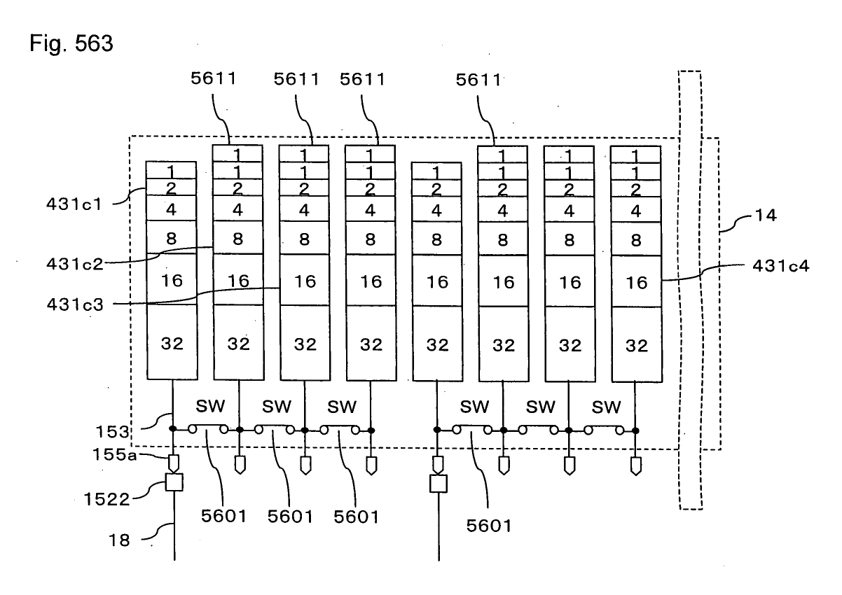

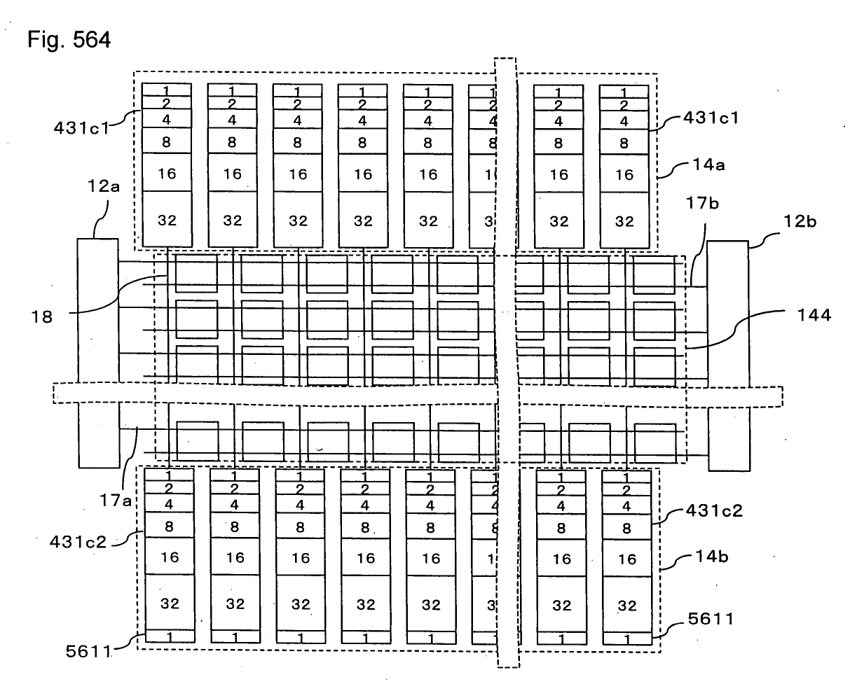

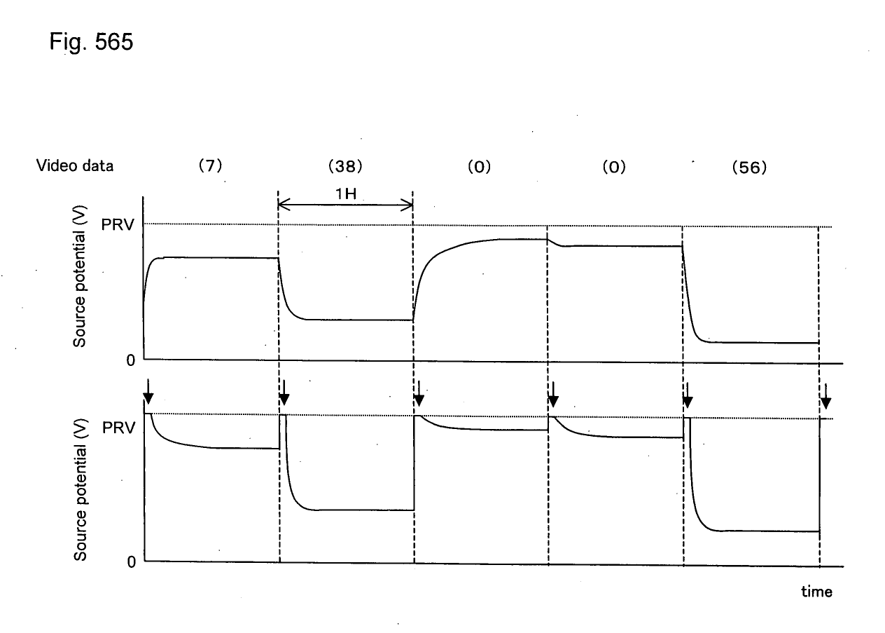

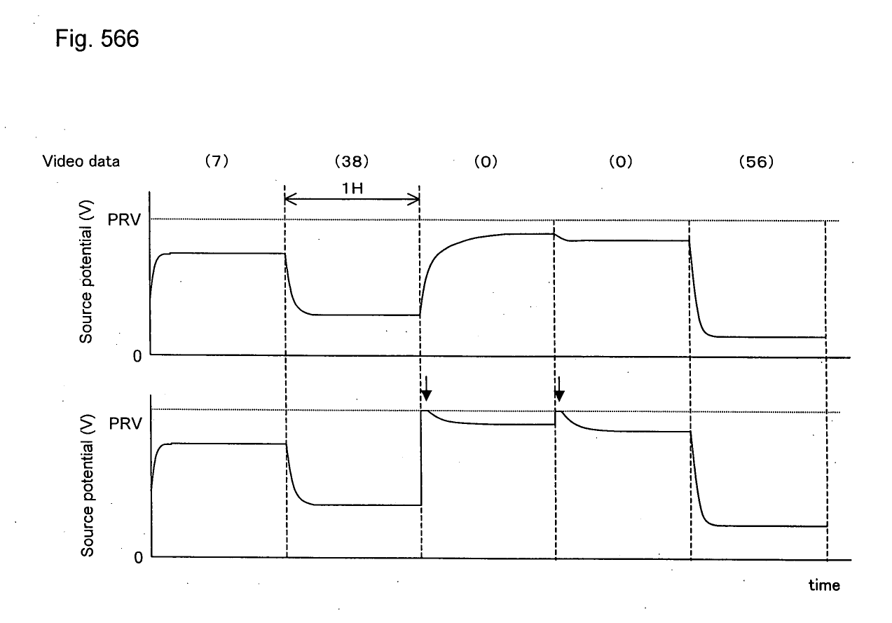

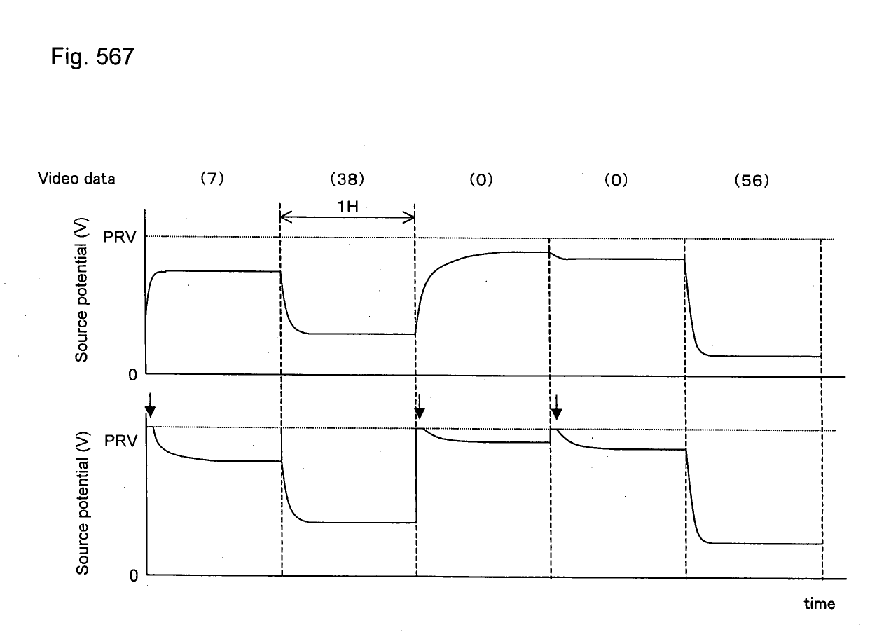

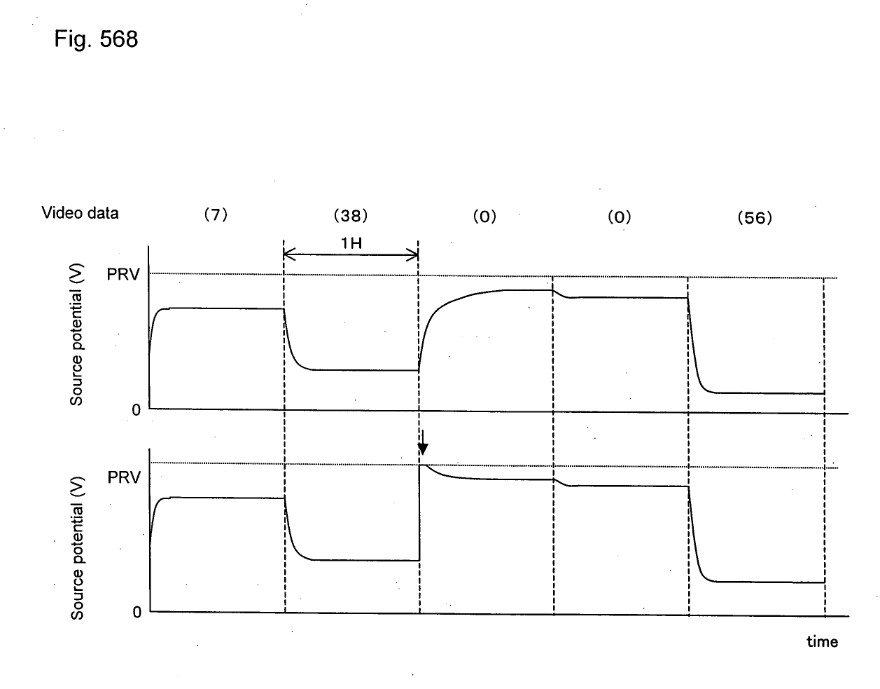

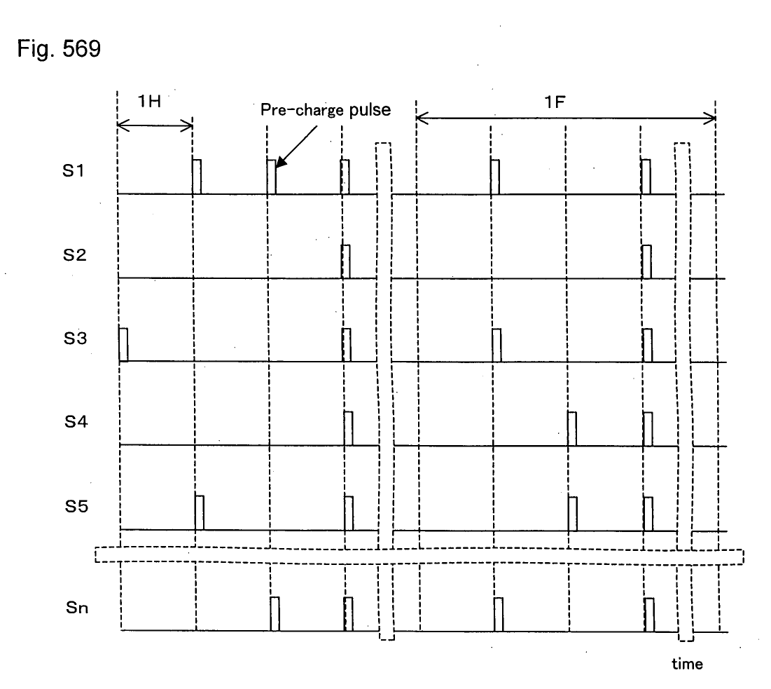

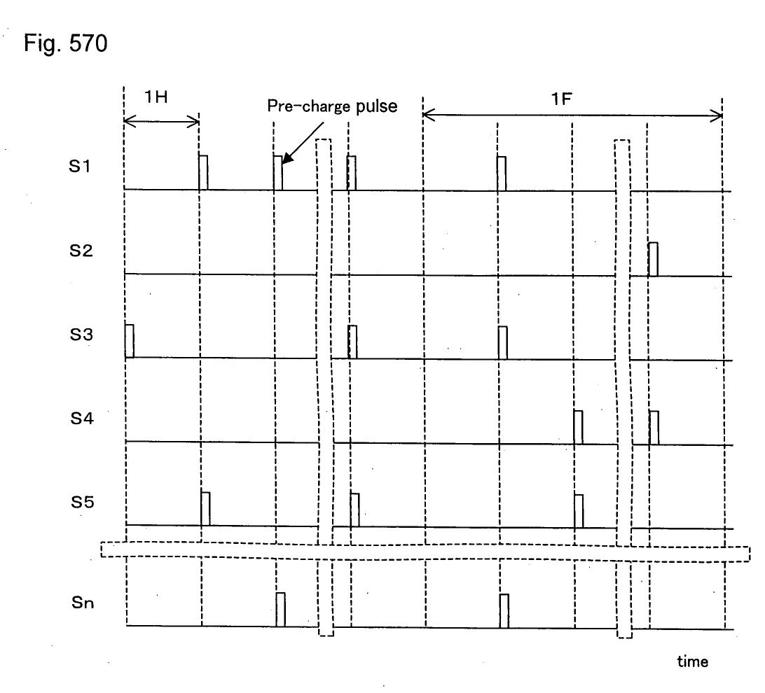

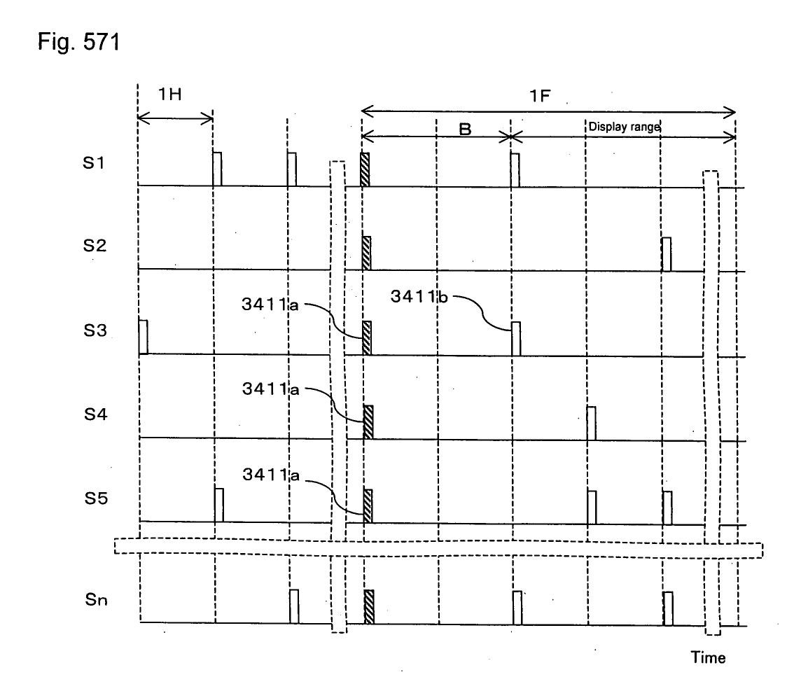

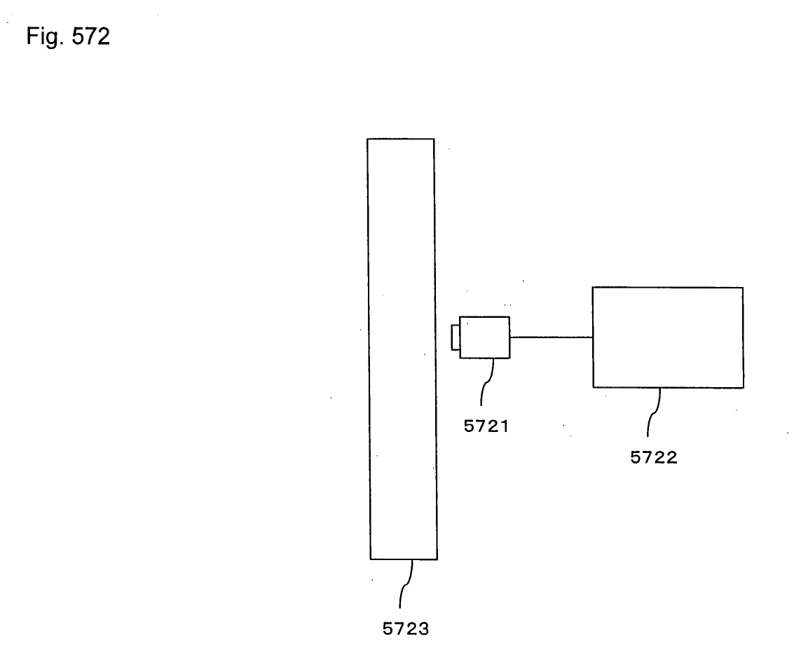

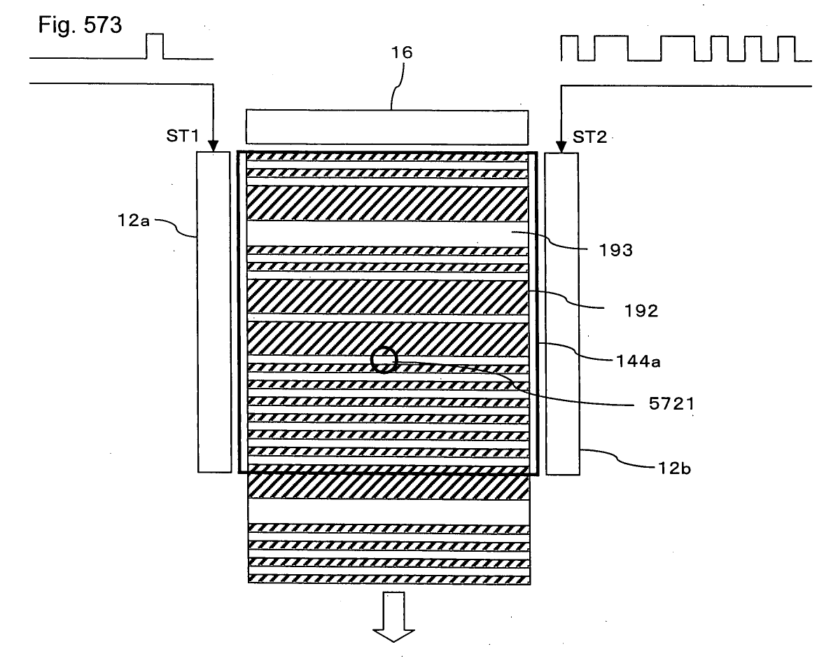

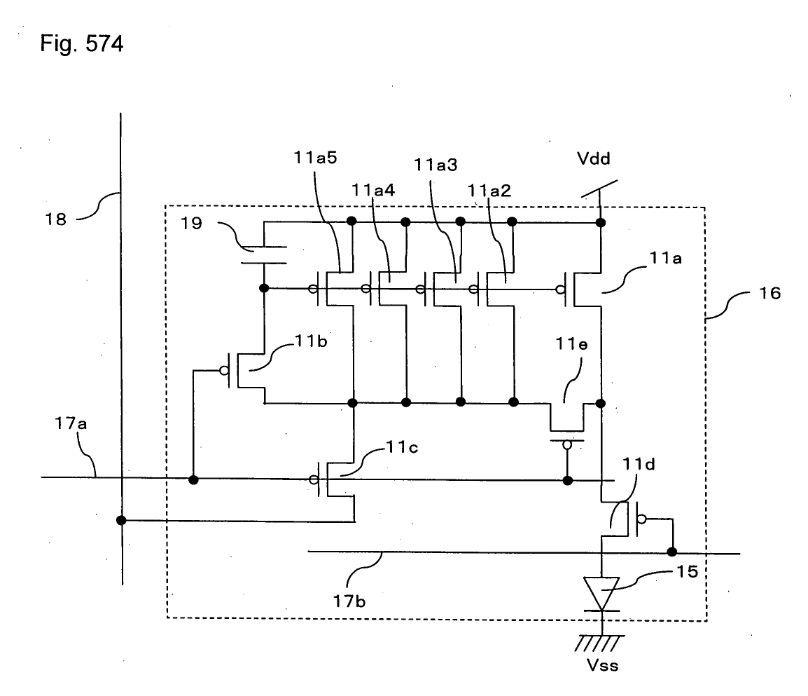

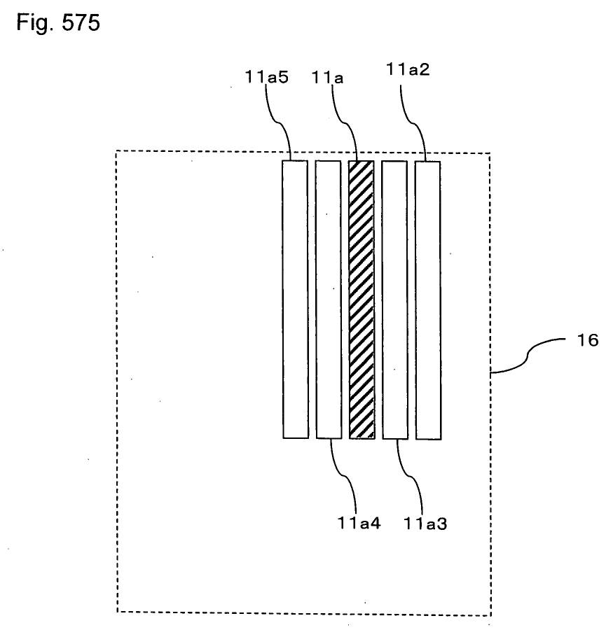

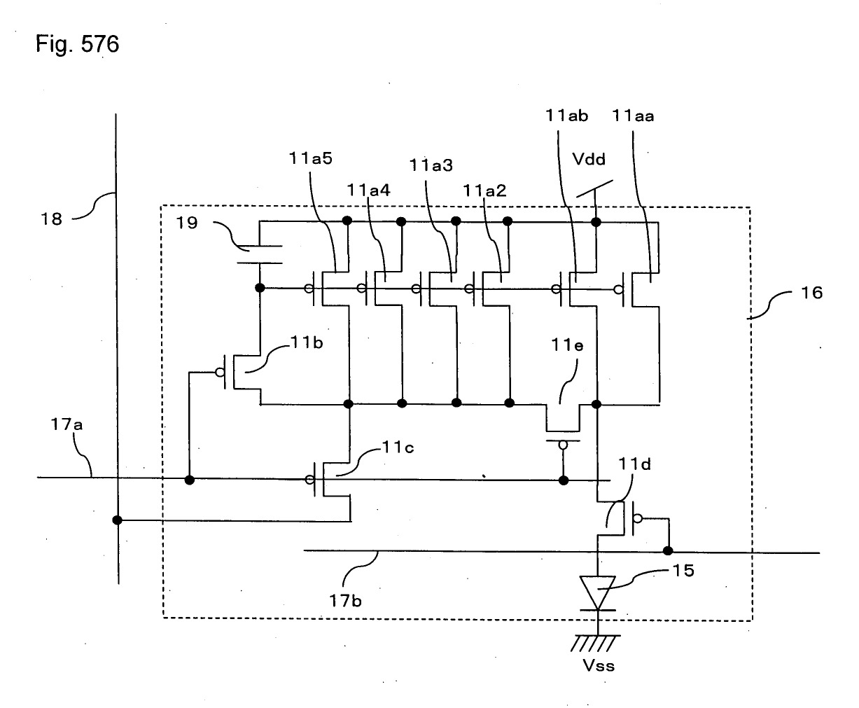

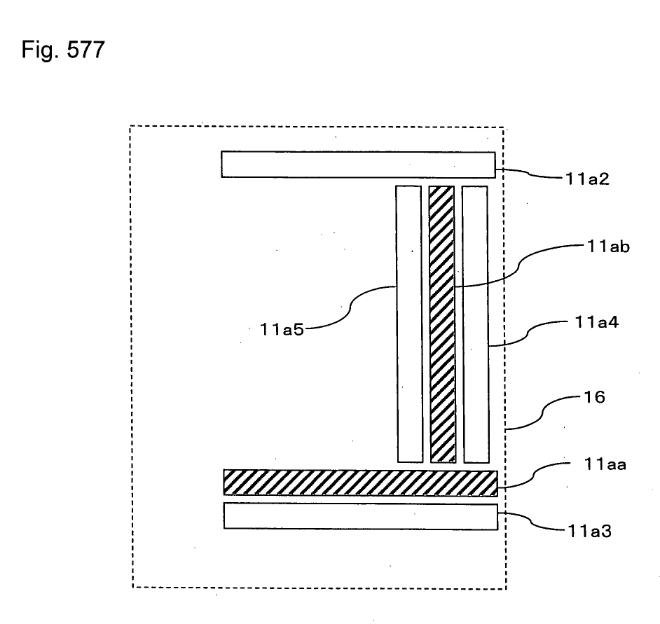

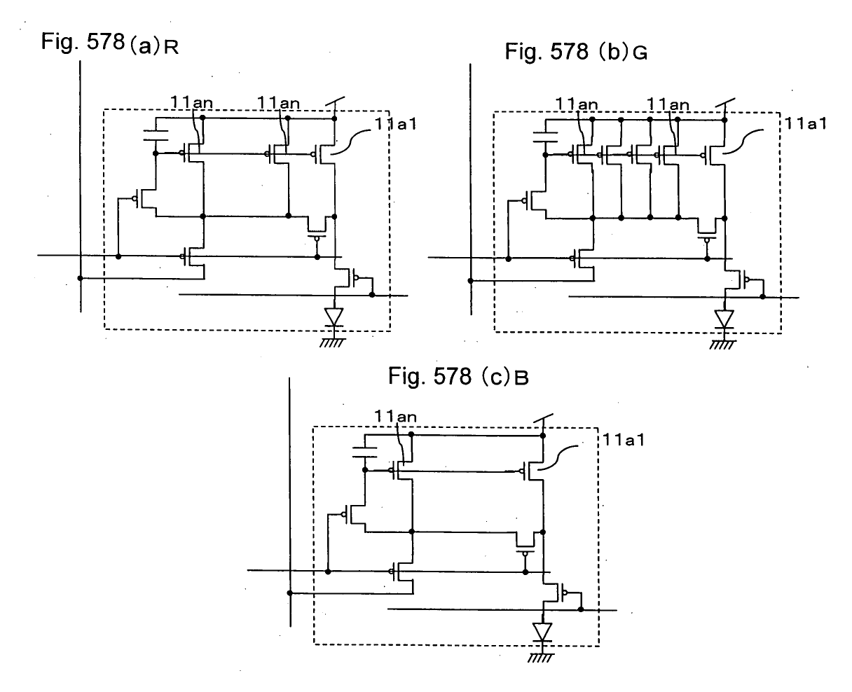

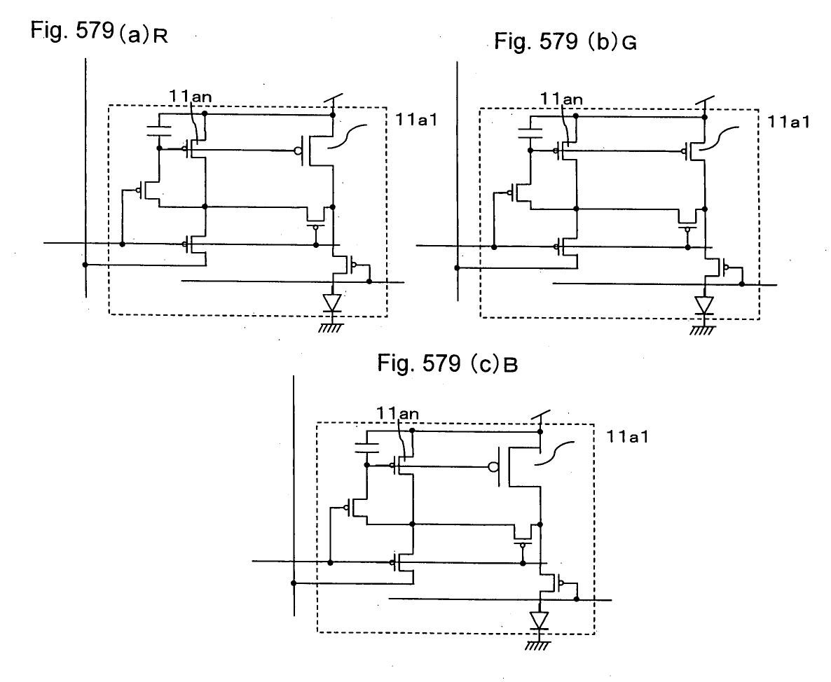

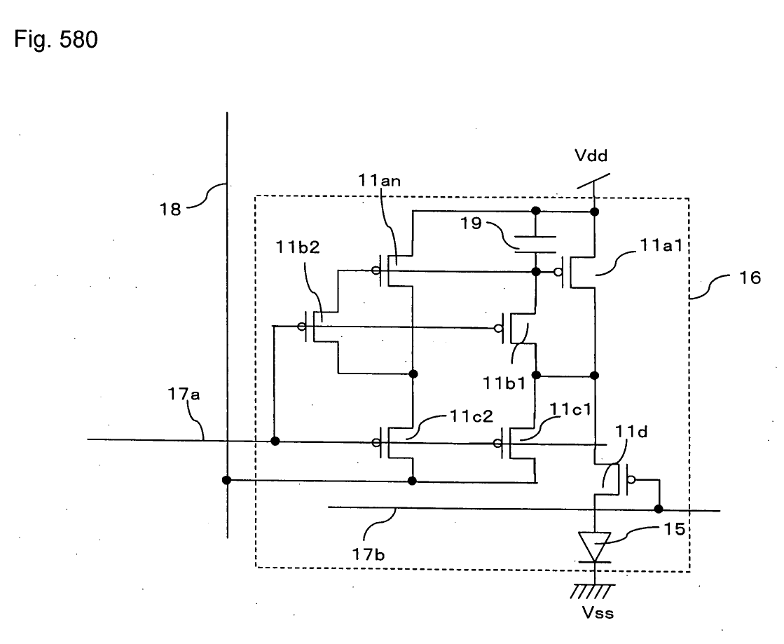

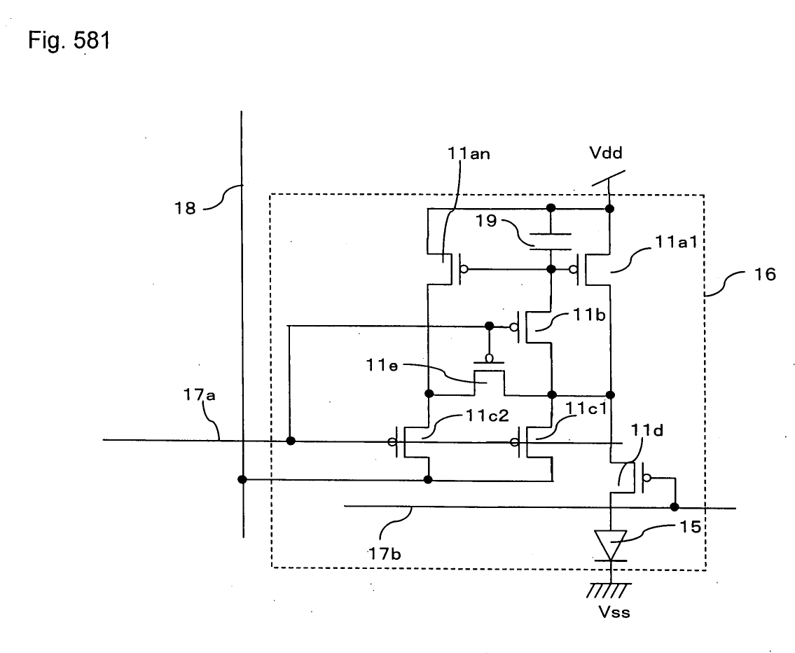

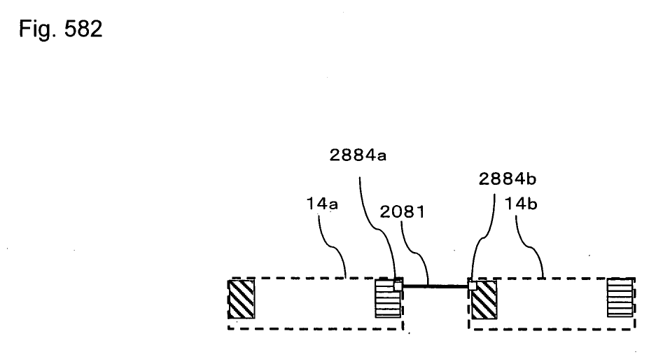

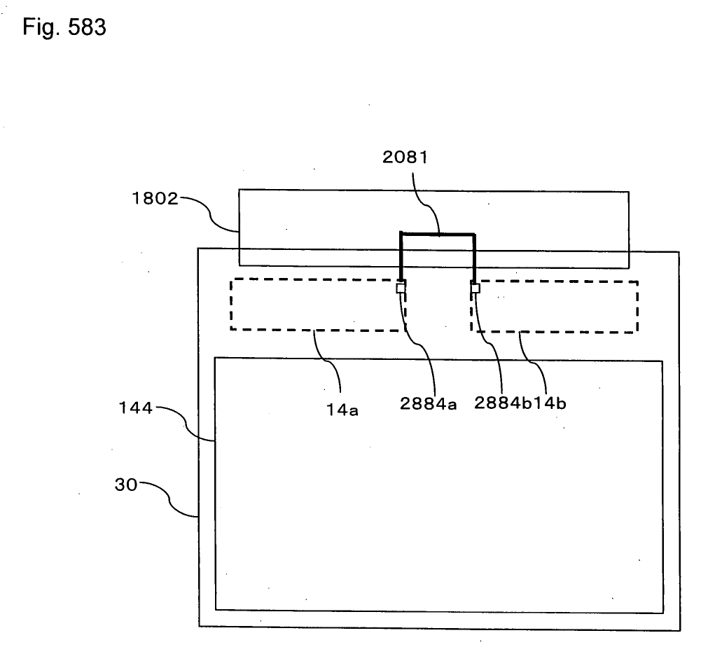

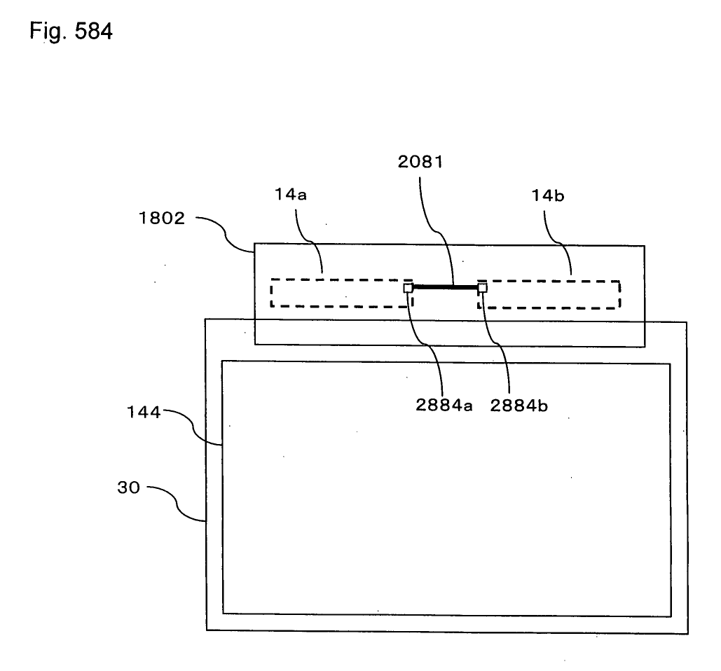

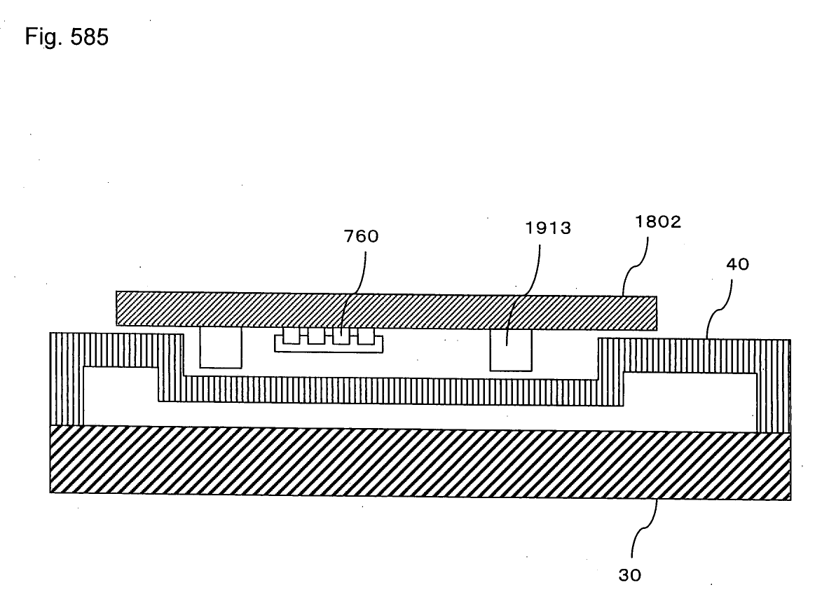

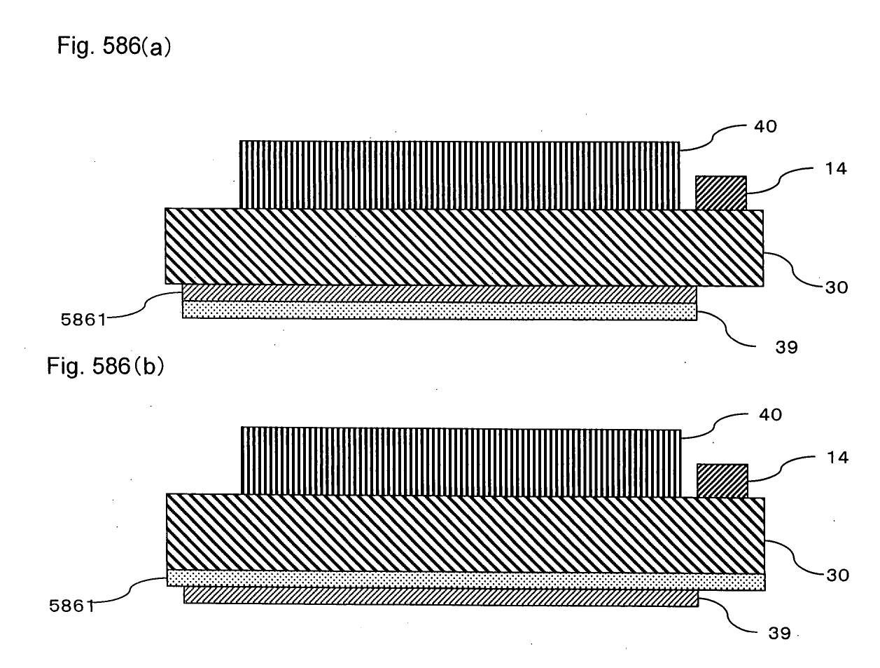

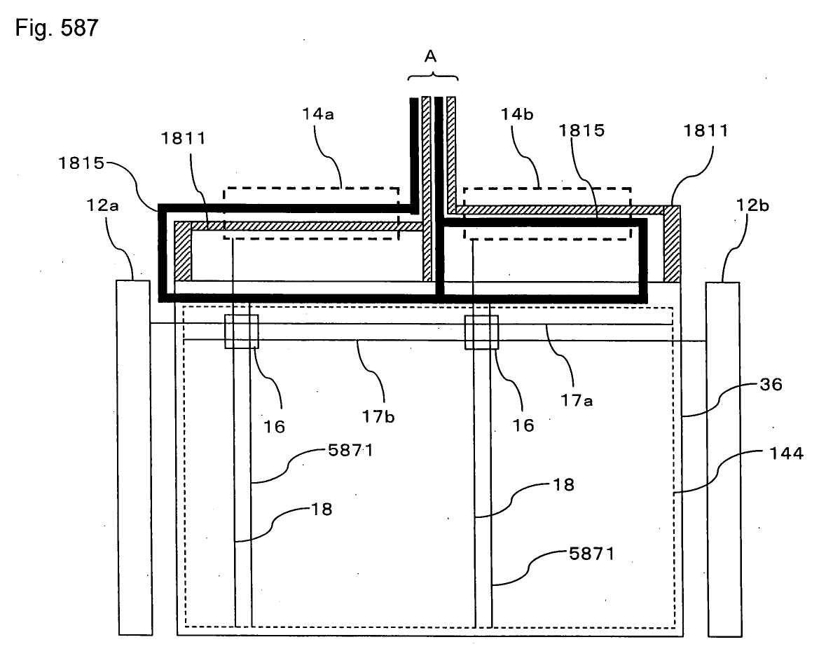

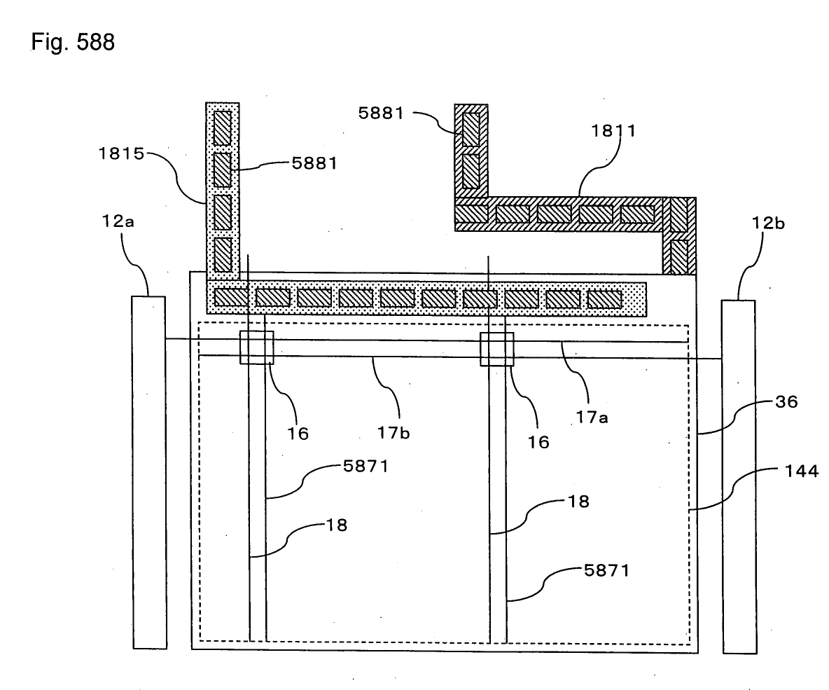

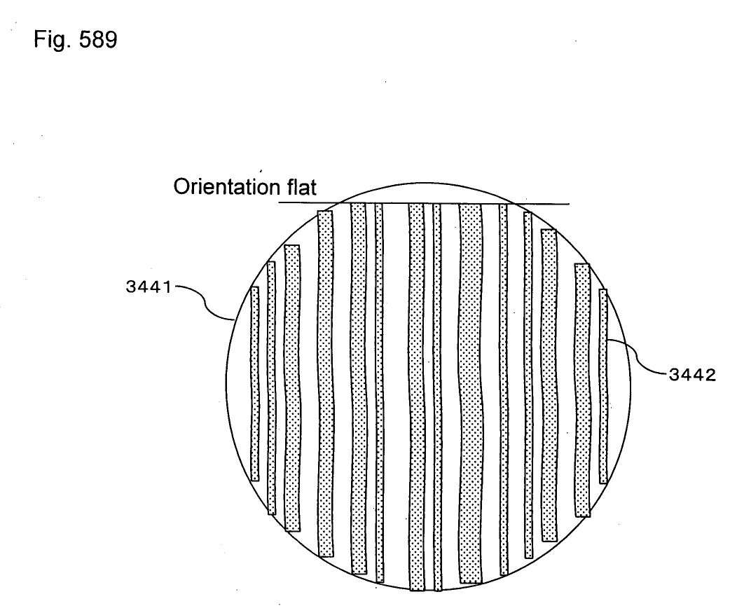

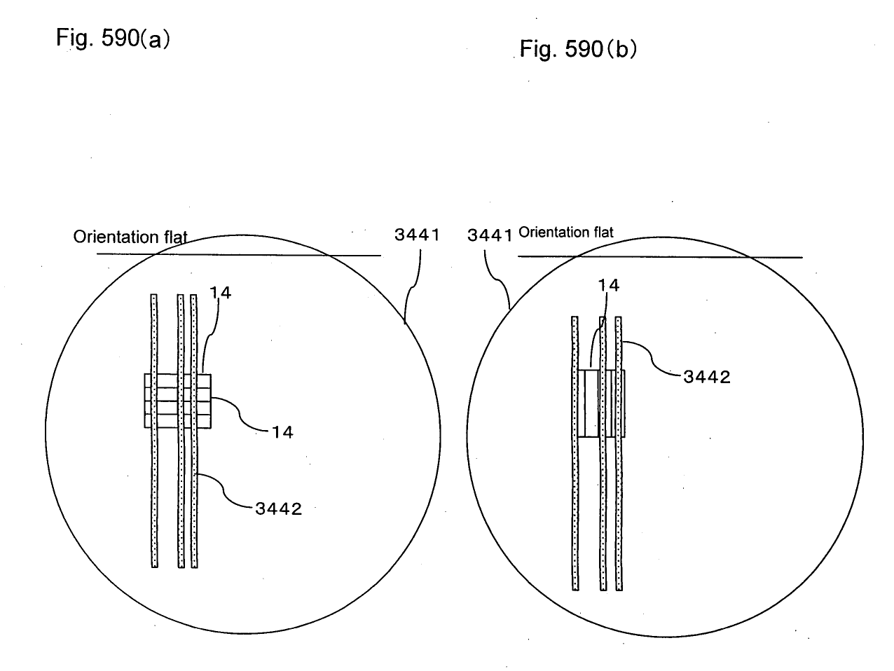

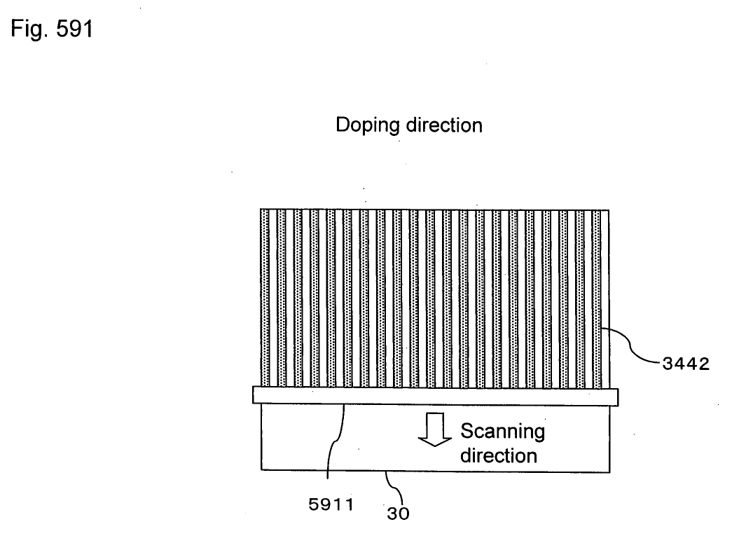

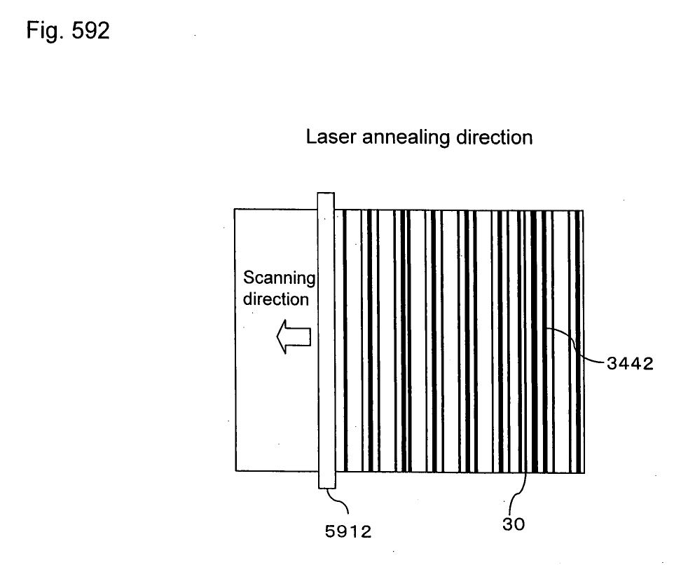

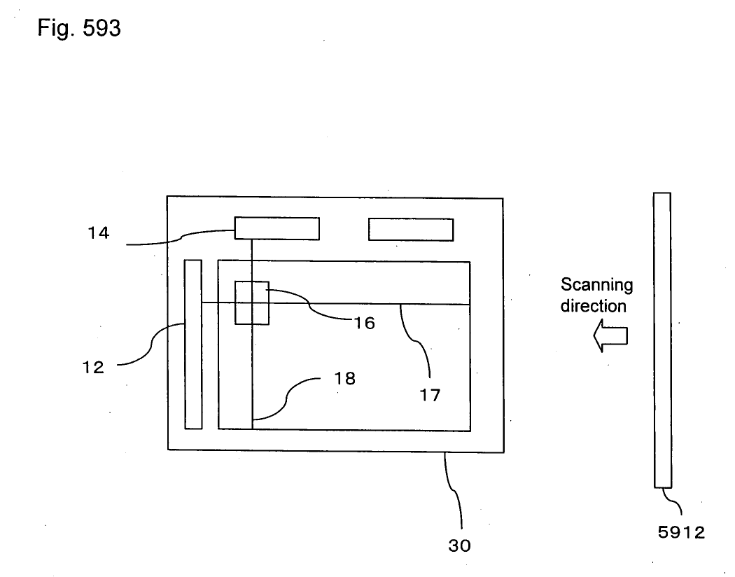

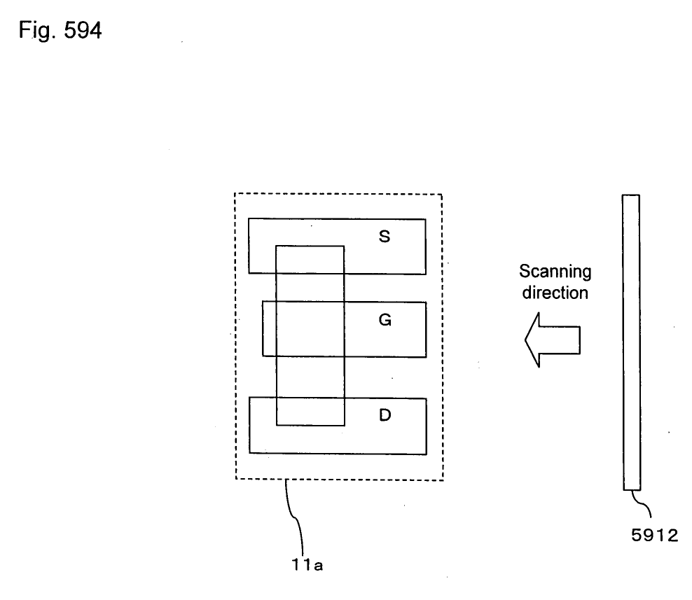

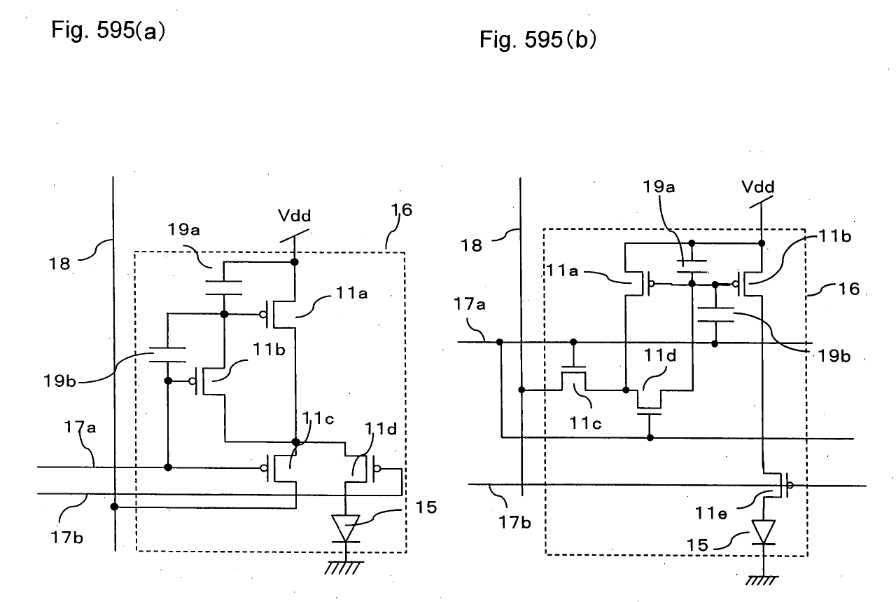

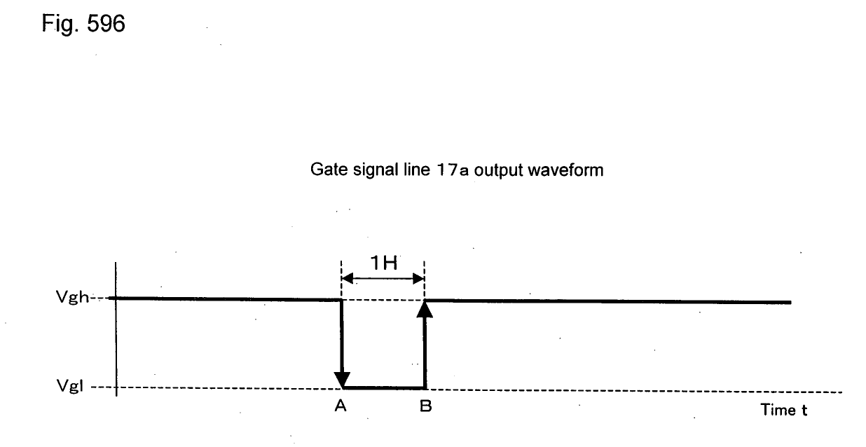

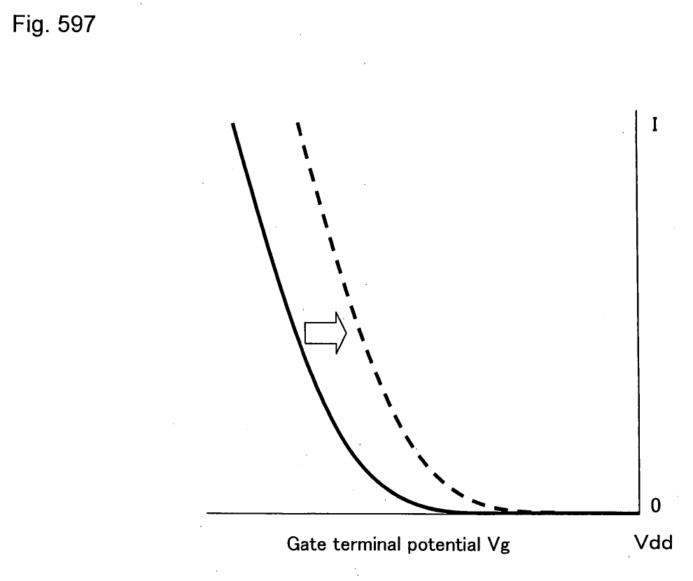

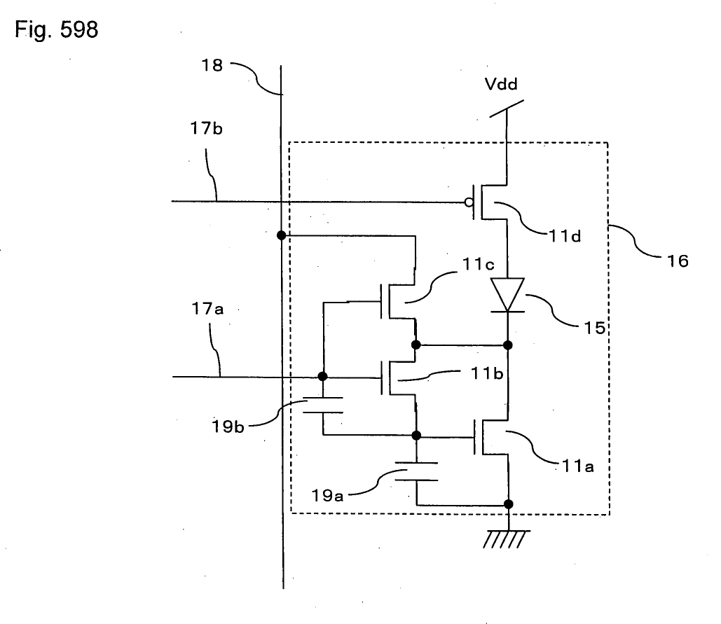

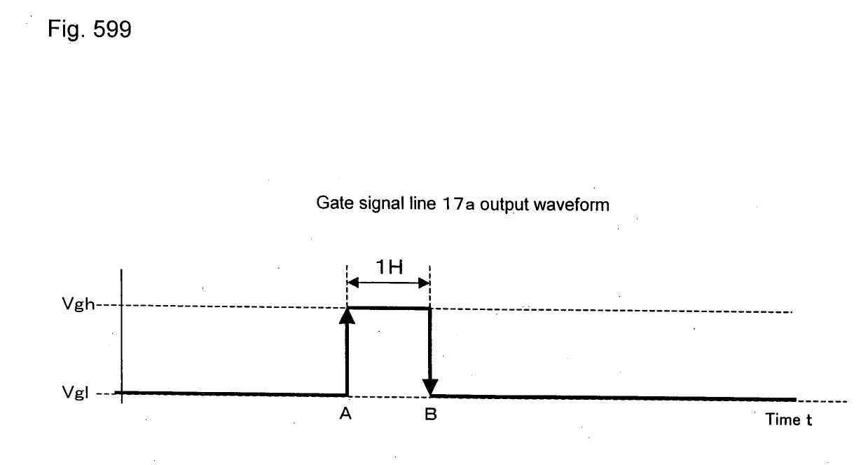

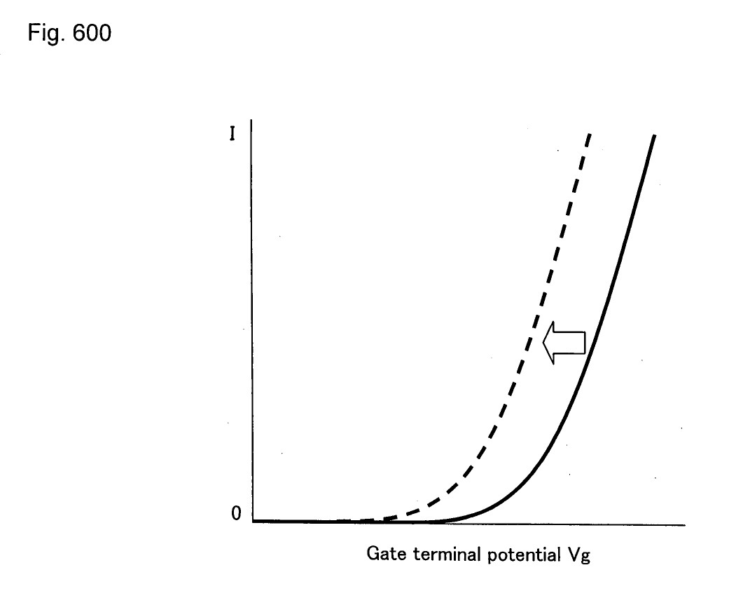

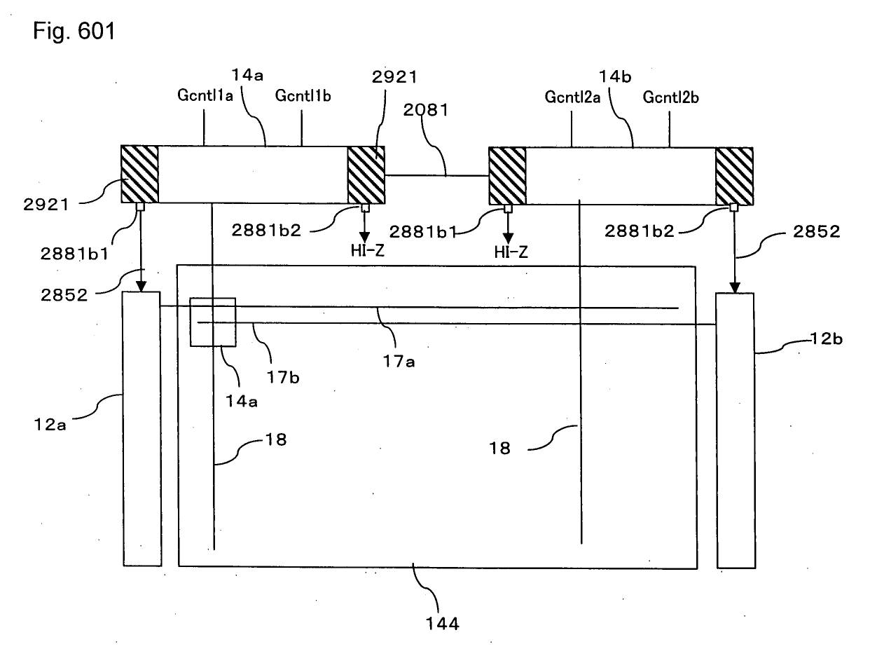

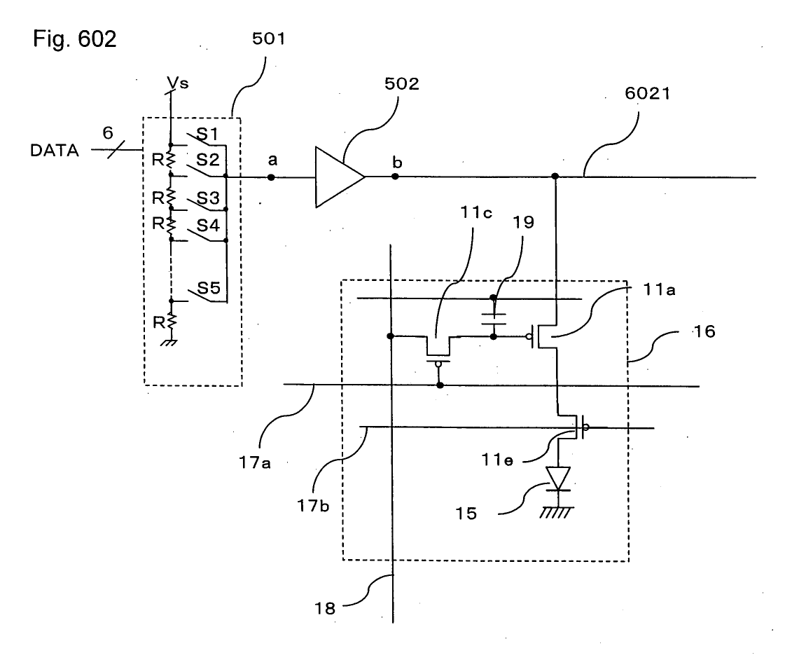

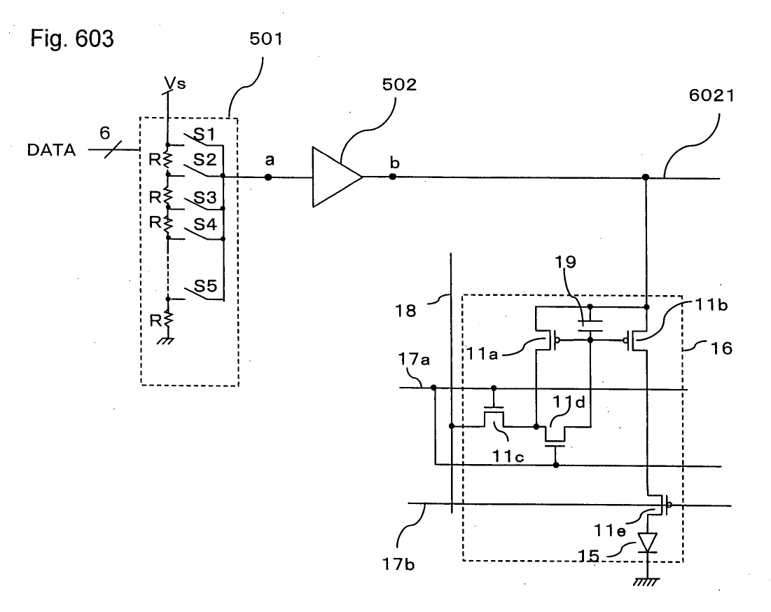

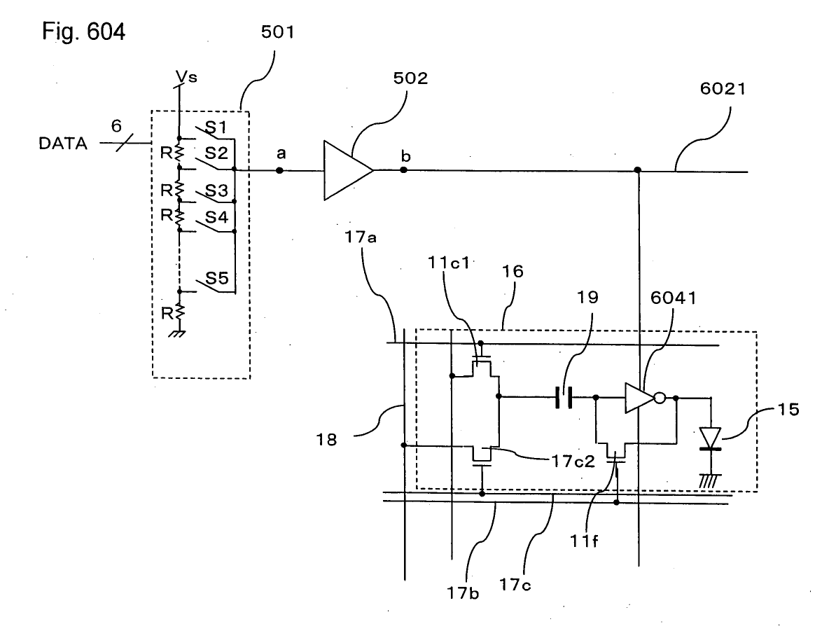

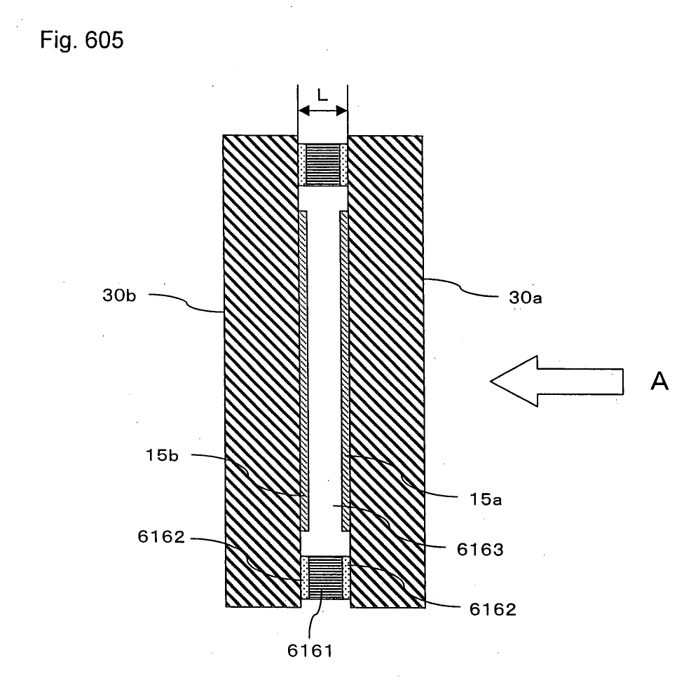

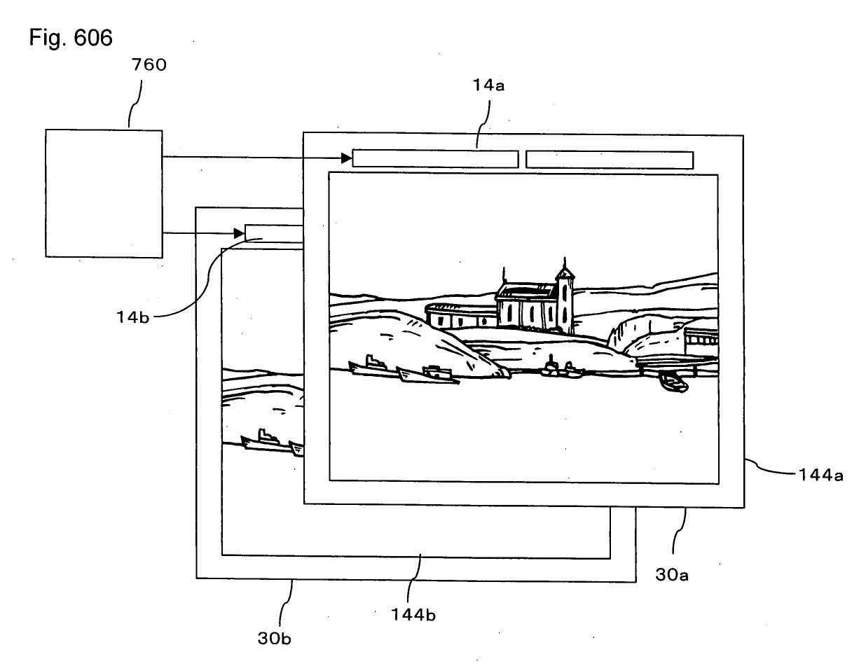

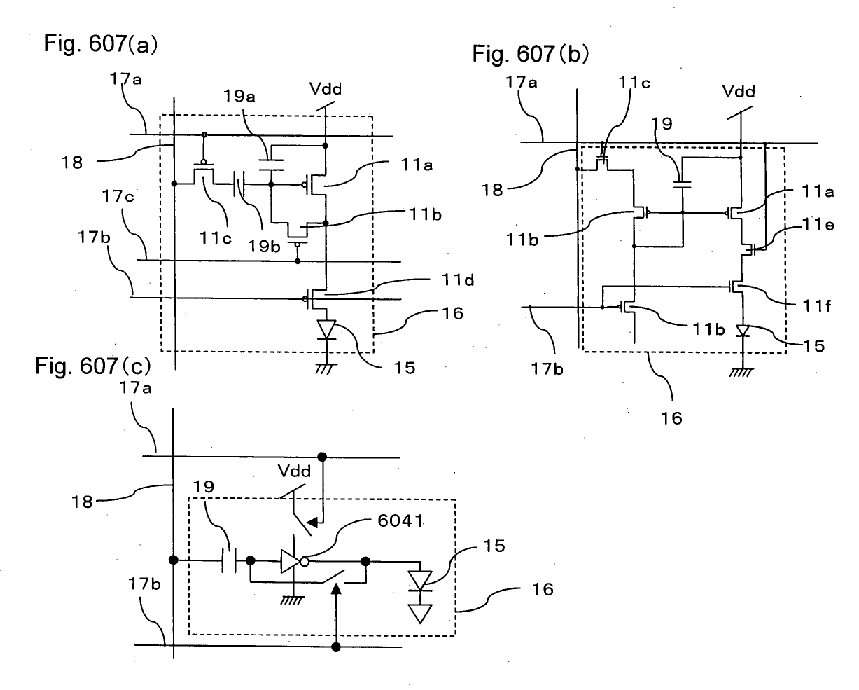

FIG. 302 is an explanatory diagram of a source driver circuit (IC) according to the present invention;

FIG. 303 is an explanatory diagram of a source driver circuit (IC) according to the present invention;

FIG. 304 is an explanatory diagram of a source driver circuit (IC) according to the present invention;

FIG. 305 is an explanatory diagram of a source driver circuit (IC) according to the present invention;

FIG. 306 is an explanatory diagram of a source driver circuit (IC) according to the present invention;

FIG. 307 is an explanatory diagram of a source driver circuit (IC) according to the present invention;

FIG. 308 is an explanatory diagram of a source driver circuit (IC) according to the present invention;

FIG. 309 is an explanatory diagram of a source driver circuit (IC) according to the present invention;

FIG. 310 is an explanatory diagram of a source driver circuit (IC) according to the present invention;

FIG. 311 is an explanatory diagram of a source driver circuit (IC) according to the present invention;

FIG. 312 is an explanatory diagram of a source driver circuit (IC) according to the present invention;

FIG. 313 is an explanatory diagram of a source driver circuit (IC) according to the present invention;

FIG. 314 is an explanatory diagram of a display panel according to the present invention;

FIG. 315 is an explanatory diagram of a display panel according to the present invention;

FIG. 316 is an explanatory diagram of a display panel according to the present invention;

FIG. 317 is an explanatory diagram illustrating a drive method of a display panel according to the present invention;

FIG. 318 is an explanatory diagram illustrating a drive method of a display panel according to the present invention;

FIG. 319 is an explanatory diagram of a display panel according to the present invention;

FIG. 320 is an explanatory diagram of a display panel according to the present invention;

FIG. 321 is an explanatory diagram illustrating a drive method of a display panel according to the present invention;

FIG. 322 is an explanatory diagram illustrating a drive method of a display panel according to the present invention;

FIG. 323 is an explanatory diagram illustrating a drive method of a display panel according to the present invention;

FIG. 324 is an explanatory diagram of a display panel according to the present invention;

FIG. 325 is an explanatory diagram of a display apparatus according to the present invention;

FIG. 326 is an explanatory diagram of a display apparatus according to the present invention;

FIG. 327 is an explanatory diagram illustrating a drive method of a display panel according to the present invention;

FIG. 328 is an explanatory diagram illustrating a drive method of a display panel according to the present invention;

FIG. 329 is an explanatory diagram illustrating a drive method of a display panel according to the present invention;

FIG. 330 is an explanatory diagram illustrating a drive method of a display panel according to the present invention;

FIG. 331 is an explanatory diagram illustrating a drive method of a display panel according to the present invention;

FIG. 332 is an explanatory diagram illustrating a drive method of a display panel according to the present invention;

FIG. 333 is an explanatory diagram illustrating a drive method of a display panel according to the present invention;

FIG. 334 is an explanatory diagram illustrating a drive method of a display panel according to the present invention;

FIG. 335 is an explanatory diagram illustrating a drive method of a display panel according to the present invention;

FIG. 336 is an explanatory diagram illustrating a drive method of a display panel according to the present invention;

FIG. 337 is an explanatory diagram illustrating a drive method of a display panel according to the present invention;

FIG. 338 is an explanatory diagram of a source driver circuit (IC) according to the present invention;

FIG. 339 is an explanatory diagram of a source driver circuit (IC) according to the present invention;

FIG. 340 is an explanatory diagram of a source driver circuit (IC) according to the present invention;

FIG. 341 is an explanatory diagram of a source driver circuit (IC) according to the present invention;

FIG. 342 is an explanatory diagram of a source driver circuit (IC) according to the present invention;

FIG. 343 is an explanatory diagram of a source driver circuit (IC) according to the present invention;

FIG. 344 is an explanatory diagram of a source driver circuit (IC) according to the present invention;

FIG. 345 is an explanatory diagram of a source driver circuit (IC) according to the present invention;

FIG. 346 is an explanatory diagram of a source driver circuit (IC) according to the present invention;

FIG. 347 is an explanatory diagram of a source driver circuit (IC) according to the present invention;

FIG. 348 is an explanatory diagram of a source driver circuit (IC) according to the present invention;

FIG. 349 is an explanatory diagram of a source driver circuit (IC) according to the present invention;

FIG. 350 is an explanatory diagram of a source driver circuit (IC) according to the present invention;

FIG. 351 is an explanatory diagram of a source driver circuit (IC) according to the present invention;

FIG. 352 is an explanatory diagram of a source driver circuit (IC) according to the present invention;

FIG. 353 is an explanatory diagram of a source driver circuit (IC) according to the present invention;

FIG. 354 is an explanatory diagram of a source driver circuit (IC) according to the present invention;

FIG. 355 is an explanatory diagram of a display apparatus according to the present invention;

FIG. 356 is an explanatory diagram of a display apparatus according to the present invention;

FIG. 357 is an explanatory diagram of a display apparatus according to the present invention;

FIG. 358 is an explanatory diagram of a display apparatus according to the present invention;

FIG. 359 is an explanatory diagram of a display apparatus according to the present invention;

FIG. 360 is an explanatory diagram of a display apparatus according to the present invention;

FIG. 361 is an explanatory diagram of a display apparatus according to the present invention;

FIG. 362 is an explanatory diagram of a display apparatus according to the present invention;

FIG. 363 is an explanatory diagram of a display apparatus according to the present invention;

FIG. 364 is an explanatory diagram of a display apparatus according to the present invention;

FIG. 365 is an explanatory diagram of a display apparatus according to the present invention;

FIG. 366 is an explanatory diagram of a display apparatus according to the present invention;

FIG. 367 is an explanatory diagram of a display apparatus according to the present invention;

FIG. 368 is an explanatory diagram of a display apparatus according to the present invention;

FIG. 369 is an explanatory diagram of a display apparatus according to the present invention;

FIG. 370 is an explanatory diagram of a display apparatus according to the present invention;

FIG. 371 is an explanatory diagram of a display apparatus according to the present invention;

FIG. 372 is an explanatory diagram of a source driver circuit (IC) according to the present invention;

FIG. 373 is an explanatory diagram of a display apparatus according to the present invention;

FIG. 374 is an explanatory diagram of a display apparatus according to the present invention;

FIG. 375 is an explanatory diagram illustrating a drive method of a display apparatus according to the present invention;

FIG. 376 is an explanatory diagram illustrating a drive method of a display apparatus according to the present invention;

FIG. 377 is an explanatory diagram of a source driver circuit (IC) according to the present invention;

FIG. 378 is an explanatory diagram of a source driver circuit (IC) according to the present invention;

FIG. 379 is an explanatory diagram of a source driver circuit (IC) according to the present invention;

FIG. 380 is an explanatory diagram illustrating a drive method of a display apparatus according to the present invention;

FIG. 381 is an explanatory diagram of a source driver circuit (IC) according to the present invention;

FIG. 382 is an explanatory diagram illustrating a drive method of a display apparatus according to the present invention;

FIG. 383 is an explanatory diagram illustrating a drive method of a display apparatus according to the present invention;

FIG. 384 is an explanatory diagram illustrating a drive method of a display apparatus according to the present invention;

FIG. 385 is an explanatory diagram illustrating a drive method of a display apparatus according to the present invention;

FIG. 386 is an explanatory diagram of a source driver circuit (IC) according to the present invention;

FIG. 387 is an explanatory diagram of a source driver circuit (IC) according to the present invention;

FIG. 388 is an explanatory diagram of a source driver circuit (IC) according to the present invention;

FIG. 389 is an explanatory diagram illustrating a drive method of a display apparatus according to the present invention;

FIG. 390 is an explanatory diagram illustrating a drive method of a display apparatus according to the present invention;

FIG. 391 is an explanatory diagram illustrating a drive method of a display apparatus according to the present invention;

FIG. 392 is an explanatory diagram of a source driver circuit (IC) according to the present invention;

FIG. 393 is an explanatory diagram of a source driver circuit (IC) according to the present invention;

FIG. 394 is an explanatory diagram of a source driver circuit (IC) according to the present invention;

FIG. 395 is an explanatory diagram of a source driver circuit (IC) according to the present invention;

FIG. 396 is an explanatory diagram of a source driver circuit (IC) according to the present invention;

FIG. 397 is an explanatory diagram of a source driver circuit (IC) according to the present invention;

FIG. 398 is an explanatory diagram of a source driver circuit (IC) according to the present invention;

FIG. 399 is an explanatory diagram of a source driver circuit (IC) according to the present invention;

FIG. 400 is an explanatory diagram of a source driver circuit (IC) according to the present invention;

FIG. 401 is an explanatory diagram of a source driver circuit (IC) according to the present invention;

FIG. 402 is an explanatory diagram of a source driver circuit (IC) according to the present invention;

FIG. 403 is an explanatory diagram of a source driver circuit (IC) according to the present invention;

FIG. 404 is an explanatory diagram of a source driver circuit (IC) according to the present invention;

FIG. 405 is an explanatory diagram of a source driver circuit (IC) according to the present invention;

FIG. 406 is an explanatory diagram of a source driver circuit (IC) according to the present invention;

FIG. 407 is an explanatory diagram of a source driver circuit (IC) according to the present invention;

FIG. 408 is an explanatory diagram of a source driver circuit (IC) according to the present invention;

FIG. 409 is an explanatory diagram illustrating a drive method of a display apparatus according to the present invention;

FIG. 410 is an explanatory diagram illustrating a drive method of a display apparatus according to the present invention;

FIG. 411 is an explanatory diagram illustrating a drive method of a display apparatus according to the present invention;

FIG. 412 is an explanatory diagram illustrating a drive method of a display apparatus according to the present invention;

FIG. 413 is an explanatory diagram illustrating a drive method of a display apparatus according to the present invention;

FIG. 414 is an explanatory diagram illustrating a drive method of a display apparatus according to the present invention;

FIG. 415 is an explanatory diagram illustrating a drive method of a display apparatus according to the present invention;

FIG. 416 is an explanatory diagram illustrating a drive method of a display apparatus according to the present invention;

FIG. 417 is an explanatory diagram illustrating a drive method of a display apparatus according to the present invention;

FIG. 418 is an explanatory diagram illustrating a drive method of a display apparatus according to the present invention;

FIG. 419 is an explanatory diagram illustrating a drive method of a display apparatus according to the present invention;

FIG. 420 is an explanatory diagram illustrating a drive method of a display apparatus according to the present invention;

FIG. 421 is an explanatory diagram illustrating a drive method of a display apparatus according to the present invention;

FIG. 422 is an explanatory diagram illustrating a drive method of a display apparatus according to the present invention;

FIG. 423 is an explanatory diagram of a display apparatus according to the present invention;

FIG. 424 is an explanatory diagram of a display apparatus according to the present invention;

FIG. 425 is an explanatory diagram of a display apparatus according to the present invention;

FIG. 426 is an explanatory diagram of a display apparatus according to the present invention;

FIG. 427 is an explanatory diagram of a source driver circuit (IC) according to the present invention;

FIG. 428 is an explanatory diagram of a source driver circuit (IC) according to the present invention;

FIG. 429 is an explanatory diagram of a source driver circuit (IC) according to the present invention;

FIG. 430 is an explanatory diagram of a source driver circuit (IC) according to the present invention;

FIG. 431 is an explanatory diagram of a source driver circuit (IC) according to the present invention;

FIG. 432 is an explanatory diagram illustrating a drive method of a display apparatus according to the present invention;

FIG. 433 is an explanatory diagram illustrating a drive method of a display apparatus according to the present invention;

FIG. 434 is an explanatory diagram illustrating a drive method of a display apparatus according to the present invention;

FIG. 435 is an explanatory diagram illustrating a drive method of a display apparatus according to the present invention;

FIG. 436 is an explanatory diagram of a checking method according to the present invention;

FIG. 437 is an explanatory diagram of a checking method according to the present invention;

FIG. 438 is an explanatory diagram of a checking method according to the present invention;

FIG. 439 is an explanatory diagram of a checking method according to the present invention;

FIG. 440 is an explanatory diagram of a checking method according to the present invention;

FIG. 441 is an explanatory diagram of a checking method according to the present invention;

FIG. 442 is an explanatory diagram illustrating a drive method of a display apparatus according to the present invention;

FIG. 443 is an explanatory diagram illustrating a drive method of a display apparatus according to the present invention;

FIG. 444 is an explanatory diagram of a display apparatus according to the present invention;

FIG. 445 is an explanatory diagram of a display apparatus according to the present invention;

FIG. 446 is an explanatory diagram of a display apparatus according to the present invention;

FIG. 447 is an explanatory diagram of a display apparatus according to the present invention;

FIG. 448 is an explanatory diagram of a display apparatus according to the present invention;

FIG. 449 is an explanatory diagram of a display apparatus according to the present invention;

FIG. 450 is an explanatory diagram of a display apparatus according to the present invention;

FIG. 451 is an explanatory diagram of a display apparatus according to the present invention;

FIG. 452 is an explanatory diagram of a display apparatus according to the present invention;

FIG. 453 is an explanatory diagram of a display apparatus according to the present invention;

FIG. 454 is an explanatory diagram of a display apparatus according to the present invention;

FIG. 455 is an explanatory diagram illustrating a drive method of a display apparatus according to the present invention;

FIG. 456 is an explanatory diagram illustrating a drive method of a display apparatus according to the present invention;

FIG. 457 is an explanatory diagram illustrating a drive method of a display apparatus according to the present invention;

FIG. 458 is an explanatory diagram illustrating a drive method of a display apparatus according to the present invention;

FIG. 459 is an explanatory diagram illustrating a drive method of a display apparatus according to the present invention;

FIG. 460 is an explanatory diagram illustrating a drive method of a display apparatus according to the present invention;

FIG. 461 is an explanatory diagram illustrating a drive method of a display apparatus according to the present invention;

FIG. 462 is an explanatory diagram illustrating a drive method of a display apparatus according to the present invention;

FIG. 463 is an explanatory diagram illustrating a drive method of a display apparatus according to the present invention;

FIG. 464 is an explanatory diagram illustrating a drive method of a display apparatus according to the present invention;

FIG. 465 is an explanatory diagram illustrating a drive method of a display apparatus according to the present invention;

FIG. 466 is an explanatory diagram illustrating a drive method of a display apparatus according to the present invention;

FIG. 467 is an explanatory diagram of a display apparatus according to the present invention;

FIG. 468 is an explanatory diagram of a display apparatus according to the present invention;

FIG. 469 is an explanatory diagram illustrating a drive method of a display apparatus according to the present invention;

FIG. 470 is an explanatory diagram of a source driver circuit (IC) according to the present invention;

FIG. 471 is an explanatory diagram of a source driver circuit (IC) according to the present invention;

FIG. 472 is an explanatory diagram of a source driver circuit (IC) according to the present invention;

FIG. 473 is an explanatory diagram of a source driver circuit (IC) according to the present invention;

FIG. 474 is an explanatory diagram illustrating a drive method of a display apparatus according to the present invention;

FIG. 475 is an explanatory diagram illustrating a drive method of a display apparatus according to the present invention;

FIG. 476 is an explanatory diagram illustrating a drive method of a display apparatus according to the present invention;

FIG. 477 is an explanatory diagram of a source driver circuit (IC) according to the present invention;

FIG. 478 is an explanatory diagram of a source driver circuit (IC) according to the present invention;

FIG. 479 is an explanatory diagram of a source driver circuit (IC) according to the present invention;

FIG. 480 is an explanatory diagram of a source driver circuit (IC) according to the present invention;

FIG. 481 is an explanatory diagram illustrating a drive method of a display apparatus according to the present invention;

FIG. 482 is an explanatory diagram illustrating a drive method of a display apparatus according to the present invention;

FIG. 483 is an explanatory diagram illustrating a drive method of a display apparatus according to the present invention;

FIG. 484 is an explanatory diagram illustrating a drive method of a display apparatus according to the present invention;

FIG. 485 is an explanatory diagram illustrating a drive method of a display apparatus (display panel) according to the present invention;

FIG. 486 is an explanatory diagram illustrating a drive method of a display apparatus (display panel) according to the present invention;

FIG. 487 is an explanatory diagram of a source driver circuit (IC) according to the present invention;

FIG. 488 is an explanatory diagram illustrating a drive method of a display apparatus (display panel) according to the present invention;

FIG. 489 is an explanatory diagram illustrating a drive method of a display apparatus (display panel) according to the present invention;

FIG. 490 is an explanatory diagram illustrating a drive method of a display apparatus (display panel) according to the present invention;

FIG. 491 is an explanatory diagram of a source driver circuit (IC) according to the present invention;

FIG. 492 is an explanatory diagram of a source driver circuit (IC) according to the present invention;

FIG. 493 is an explanatory diagram of a source driver circuit (IC) according to the present invention;

FIG. 494 is an explanatory diagram of a source driver circuit (IC) according to the present invention;

FIG. 495 is an explanatory diagram of a source driver circuit (IC) according to the present invention;

FIG. 496 is an explanatory diagram of a source driver circuit (IC) according to the present invention;

FIG. 497 is an explanatory diagram of a source driver circuit (IC) according to the present invention;

FIG. 498 is an explanatory diagram of a source driver circuit (IC) according to the present invention;

FIG. 499 is an explanatory diagram of a source driver circuit (IC) according to the present invention;

FIG. 500 is an explanatory diagram of a source driver circuit (IC) according to the present invention;

FIG. 501 is an explanatory diagram of a source driver circuit (IC) according to the present invention;

FIG. 502 is an explanatory diagram of a source driver circuit (IC) according to the present invention;

FIG. 503 is an explanatory diagram of a source driver circuit (IC) according to the present invention;

FIG. 504 is an explanatory diagram of a display apparatus according to the present invention;

FIG. 505 is an explanatory diagram of a display apparatus according to the present invention;

FIG. 506 is an explanatory diagram of a display apparatus according to the present invention;

FIG. 507 is an explanatory diagram of a display apparatus according to the present invention;

FIG. 508 is an explanatory diagram of a display apparatus according to the present invention;

FIG. 509 is an explanatory diagram of a display apparatus according to the present invention;

FIG. 510 is an explanatory diagram of a source driver circuit (IC) according to the present invention;

FIG. 511 is an explanatory diagram of a source driver circuit (IC) according to the present invention;

FIG. 512 is an explanatory diagram of a source driver circuit (IC) according to the present invention;

FIG. 513 is an explanatory diagram of a source driver circuit (IC) according to the present invention;

FIG. 514 is an explanatory diagram of a source driver circuit (IC) according to the present invention;

FIG. 515 is an explanatory diagram illustrating a drive method of a display apparatus according to the present invention;

FIG. 516 is an explanatory diagram illustrating a drive method of a display apparatus according to the present invention;

FIG. 517 is an explanatory diagram illustrating a drive method of a display apparatus according to the present invention;

FIG. 518 is an explanatory diagram illustrating a drive method of a display apparatus according to the present invention;

FIG. 519 is an explanatory diagram of a display apparatus according to the present invention;

FIG. 520 is an explanatory diagram of a display apparatus according to the present invention;

FIG. 521 is an explanatory diagram of a display apparatus according to the present invention;

FIG. 522 is an explanatory diagram of a display apparatus according to the present invention;

FIG. 523 is an explanatory diagram of a display apparatus according to the present invention;

FIG. 524 is an explanatory diagram of a display apparatus according to the present invention;

FIG. 525 is an explanatory diagram of a source driver circuit (IC) according to the present invention;

FIG. 526 is an explanatory diagram of a source driver circuit (IC) according to the present invention;

FIG. 527 is an explanatory diagram of a source driver circuit (IC) according to the present invention;

FIG. 528 is an explanatory diagram of a display apparatus according to the present invention;

FIG. 529 is an explanatory diagram of a display apparatus according to the present invention;

FIG. 530 is an explanatory diagram of a display apparatus according to the present invention;

FIG. 531 is an explanatory diagram of a display apparatus according to the present invention;

FIG. 532 is an explanatory diagram illustrating a drive method of a display apparatus according to the present invention;

FIG. 533 is an explanatory diagram of a display apparatus according to the present invention;

FIG. 534 is an explanatory diagram illustrating a drive method of a display apparatus according to the present invention;

FIG. 535 is an explanatory diagram illustrating a drive method of a display apparatus according to the present invention;

FIG. 536 is an explanatory diagram illustrating a drive method of a display apparatus according to the present invention;

FIG. 537 is an explanatory diagram illustrating a drive method of a display apparatus according to the present invention;

FIG. 538 is an explanatory diagram illustrating a drive method of a display apparatus according to the present invention;

FIG. 539 is an explanatory diagram illustrating a power circuit of a display apparatus according to the present invention;

FIG. 540 is an explanatory diagram illustrating a power circuit of a display apparatus according to the present invention;

FIG. 541 is an explanatory diagram illustrating a power circuit of a display apparatus according to the present invention;

FIG. 542 is an explanatory diagram illustrating a power circuit of a display apparatus according to the present invention;

FIG. 543 is an explanatory diagram illustrating a power circuit of a display apparatus according to the present invention;

FIG. 544 is an explanatory diagram illustrating a power circuit of a display apparatus according to the present invention;

FIG. 545 is an explanatory diagram illustrating a power circuit of a display apparatus according to the present invention;

FIG. 546 is an explanatory diagram illustrating a power circuit of a display apparatus according to the present invention;

FIG. 547 is an explanatory diagram of a source driver circuit (IC) according to the present invention;

FIG. 548 is an explanatory diagram of a source driver circuit (IC) according to the present invention;

FIG. 549 is an explanatory diagram of a source driver circuit (IC) according to the present invention;

FIG. 550 is an explanatory diagram of a source driver circuit (IC) according to the present invention;

FIG. 551 is an explanatory diagram of a source driver circuit (IC) according to the present invention;

FIG. 552 is an explanatory diagram of a source driver circuit (IC) according to the present invention;

FIG. 553 is an explanatory diagram of a source driver circuit (IC) according to the present invention;

FIG. 554 is an explanatory diagram of a source driver circuit (IC) according to the present invention;

FIG. 555 is an explanatory diagram of a source driver circuit (IC) according to the present invention;

FIG. 556 is an explanatory diagram of a source driver circuit (IC) according to the present invention;

FIG. 557 is an explanatory diagram of a source driver circuit (IC) according to the present invention;

FIG. 558 is an explanatory diagram of a source driver circuit (IC) according to the present invention;

FIG. 559 is an explanatory diagram of a source driver circuit (IC) according to the present invention;

FIG. 560 is an explanatory diagram of a source driver circuit (IC) according to the present invention;

FIG. 561 is an explanatory diagram of a source driver circuit (IC) according to the present invention;

FIG. 562 is an explanatory diagram of a source driver circuit (IC) according to the present invention;

FIG. 563 is an explanatory diagram of a source driver circuit (IC) according to the present invention;

FIG. 564 is an explanatory diagram of a source driver circuit (IC) according to the present invention;

FIG. 565 is an explanatory diagram illustrating a drive method of a display apparatus according to the present invention;

FIG. 566 is an explanatory diagram illustrating a drive method of a display apparatus according to the present invention;

FIG. 567 is an explanatory diagram illustrating a drive method of a display apparatus according to the present invention;

FIG. 568 is an explanatory diagram illustrating a drive method of a display apparatus according to the present invention;

FIG. 569 is an explanatory diagram illustrating a drive method of a display apparatus according to the present invention;

FIG. 570 is an explanatory diagram illustrating a drive method of a display apparatus according to the present invention;

FIG. 571 is an explanatory diagram illustrating a drive method of a display apparatus according to the present invention;

FIG. 572 is an explanatory diagram of a display apparatus according to the present invention;

FIG. 573 is an explanatory diagram of a display apparatus according to the present invention;

FIG. 574 is an explanatory diagram of a display panel according to the present invention;

FIG. 575 is an explanatory diagram of a display panel according to the present invention;

FIG. 576 is an explanatory diagram of a display panel according to the present invention;

FIG. 577 is an explanatory diagram of a display panel according to the present invention;

FIG. 578 is an explanatory diagram of a display panel according to the present invention;

FIG. 579 is an explanatory diagram of a display panel according to the present invention;

FIG. 580 is an explanatory diagram of a display panel according to the present invention;

FIG. 581 is an explanatory diagram of a display panel according to the present invention;

FIG. 582 is an explanatory diagram of a display apparatus according to the present invention;

FIG. 583 is an explanatory diagram of a display apparatus according to the present invention;

FIG. 584 is an explanatory diagram of a display apparatus according to the present invention;

FIG. 585 is an explanatory diagram of a display apparatus according to the present invention;

FIG. 586 is an explanatory diagram of a display apparatus according to the present invention;

FIG. 587 is an explanatory diagram of a display apparatus according to the present invention;

FIG. 588 is an explanatory diagram of a display apparatus according to the present invention;

FIG. 589 is an explanatory diagram of a source driver circuit (IC) according to the present invention;

FIG. 590 is an explanatory diagram of a source driver circuit (IC) according to the present invention;

FIG. 591 is an explanatory diagram illustrating a manufacturing method of a display panel according to the present invention;

FIG. 592 is an explanatory diagram illustrating a manufacturing method of a display panel according to the present invention;

FIG. 593 is an explanatory diagram illustrating a manufacturing method of a display panel according to the present invention;

FIG. 594 is an explanatory diagram illustrating a manufacturing method of a display panel according to the present invention;

FIG. 595 is an explanatory diagram of a display panel according to the present invention;

FIG. 596 is an explanatory diagram of a display panel according to the present invention;

FIG. 597 is an explanatory diagram of a display panel according to the present invention;

FIG. 598 is an explanatory diagram of a display panel according to the present invention;

FIG. 599 is an explanatory diagram of a display panel according to the present invention;

FIG. 600 is an explanatory diagram of a display panel according to the present invention;

FIG. 601 is an explanatory diagram of a display apparatus according to the present invention;

FIG. 602 is an explanatory diagram of a display apparatus according to the present invention;

FIG. 603 is an explanatory diagram of a display apparatus according to the present invention;

FIG. 604 is an explanatory diagram of a display apparatus according to the present invention;

FIG. 605 is an explanatory diagram of a display apparatus according to the present invention;

FIG. 606 is an explanatory diagram of a display apparatus according to the present invention; and

FIG. 607 is an explanatory diagram of a display panel according to the present invention.

### DESCRIPTION OF SYMBOLS

11 Transistor (TFT, thin-film transistor)
12 Gate driver (circuit) IC
14 Source driver circuit (IC)
15 EL element (light-emitting element)
16 Pixel
17 Gate signal line
18 Source signal line
19 Storage capacitance (additional capacitor, additional capacitance)
29 EL film
30 Array board
31 Bank (rib)
32 Interlayer insulating film
34 Contact connector
35 Pixel electrode
36 Cathode electrode
37 Desiccant
38 λ/4 plate (λ/4 film, phase plate, phase film)
39 Polarizing plate
40 Sealing lid
41 Thin encapsulation film
71 Switching circuit (analog switch)
141 Shift register
142 Inverter
143 Output buffer
144 Display area (display screen)
150 Internal wiring (output wiring)
151 Switch (on/off means)
153 Gate wiring
154 Current source (unit transistor)
155 Output terminal
157, 158 Transistor
161 Coincidence circuit
162 Counter circuit
163 AND
164 Current output circuit
171 Protection diode
172 Surge limiting resistor
191 Write pixel row
192 Non-display (non-illuminated) area
193 Display (illuminated) area
431 Transistor group
501 Electronic regulator (voltage variable means)
502 Operational amplifier
601 Constant current circuit
641 Ladder resistance
642 Switch circuit
643 Voltage input/output circuit (voltage input/output terminal)
661 DA conversion circuit
760 Control circuit (IC) (control means)
761 Pre-charge control circuit
764 Gamma conversion circuit
765 Frame Rate Control (FRC) circuit
771 Latch circuit (holding circuit, holding means, data storing circuit)
772 Selector circuit (Selection means, conversion means)
773 Pre-charge circuit
811 Differential circuit
821 Serial-parallel conversion circuit (control IC)
831 Control IC (circuit) (control means)
841 Padder circuit
851 Switch circuit (conversion means)
852 Decoder circuit
856 AI processing circuit (peak current suppression control, dynamic range enlargement, etc.)
857 Moving picture detection (ID process)
858 Color management processing circuit (color compensation/correction, color temperature correction circuit)
859 Calculating circuit (MPU, CPU)
861 Variable amplifier
862 Sampling circuit (data holding circuit, signal latch circuit)
881, 882 Multiplier
883 Adder
884 Sum total circuit (SUM circuit, data processing circuit, total current arithmetic circuit)
1191 DCDC converter (voltage value conversion circuit, DC power circuit)
1193 Regulator
1261 Antenna
1262 Key
1263 Body
1264 Display panel
1271 Voltage gradation circuit (program voltage generation circuit)
1311 Decoder
1431 Adder
1541 Eye ring
1542 Magnifying lens
1543 Convex lens
1551 Supporting point (pivot point, supporting point section)
1552 Taking lens (taking means)
1553 Storage section
1554 Switch
1561 Body
1562 Photographic section
1563 Shutter switch
1571 Mounting frame
1572 Leg
1573 Mount
1574 Fixed part
1153 Control electrode
1582 Video signal circuit
1583 Electron emission protuberance
1584 Holding circuit
1585 On/off control circuit
1621 Trimming apparatus (trimming means, adjustment mean)
1622 Laser light
1623 Resistance (adjustment portion)
1681 Correction (adjustment) transistor
1691 Source terminal
1692 Gate terminal
1693 Drain terminal
1694 Transistor
1731 Selection switch (selecting means)
1732 Common line
1733 Current meter (current measuring means)
1734 Terminal electrode
1801 Connecter terminal (connection terminal)
1802 Flexible board
1811 Cathode wiring
1812 Cathode connecting position
1813 Gate driver signal
1814 Source driver signal
1815 Anode wiring
1881 Current holding circuit
1882 Gradation current wiring
1883 Output control terminal
1884 Program current generation circuit
1885 Selection signal line
1891 Sampling switch
1901 Differential signal
1912 Power module
1913 Coil (transformer circuit, boosting circuit)
1914 Connection terminal
2021 Short-circuiting wire
2031 Anode terminal wiring
2032 Short-circuiting tip (electrical short-circuiting means)
2033 Tip terminal
2034 Source signal line terminal
2041 Short-circuiting liquid (electrical short-circuiting gel, electrical short-circuiting resin, electrical short-circuiting means)
2081 Cascade wire
2191 Switch (on/off means)
2231 On/off control means
2232 Checking transistor
2251 Protective diodes
2252 Voltage (current) wiring
2261 Voltage source (checking signal generation means, checking signal generation part)
2280 Output circuit (output stage, current output circuit, current holding circuit)
2281 Transistor
2282 Gate signal line
2283 Current signal line
2284 Gate signal line
2289 Condenser
2301 Reset circuit
2311 Switch transistor
2285 Gate signal line
2391 I-V conversion circuit
trb Transistor group
tb Transistor group
2471 Polysilicon current-holding circuit
2501 Trimmer-adjuster
2511 Ssealing resin
2512 Speaker
2513 Sealing film
2514 Space
2611 Regulator
2612 Charge pump circuit
2621 Switching circuit (converting circuit)
2622 Transformer
2623 Smoothing circuit
2741 Dummy pixel row
2831 Inverted-output generator circuits
2841 FF (flip-flop circuit, delay circuit)
2851 Signal generator circuit
2852 Wiring
2871 Correction data calculating circuit
2872 Current measuring circuit
2873 Probe
2874 Correction circuit (data conversion circuit)
2881 Gate wiring pad
2882 Gate wiring pad
2883 Input signal line pad
2884 Output signal line pad
2885 Wiring
2901 Input signal line
2902 Terminal electrode
2903 Anode wiring
2904 Gold bump
2911 Flexible board
2921 Differential-parallel signal converter circuit
2931 Resistance array
2941 Voltage selector circuit
2951 Selector circuit
3031 Flash memory (data holding circuit)
3051 Luminance meter
3052 Calculator
3053 Control circuit
3141 Light-shielding film
3271 Battery (battery, power supply means)
3272 Power-supply module (voltage generation means)
3451 Adder
3611 PLL circuit
3681 Differential signal-parallel signal conversion circuit
3682 Impedance setting circuit
3751 Capacitor signal line
3752 Capacitor driver circuit (IC)
3861 Overcurrent (pre-charge current or discharge current) transistor
3881 Comparator (data comparison means, arithmetic means, control means)
4011 Gate wiring
K Overcurrent bit
P Pre-charge bit
4371 Current meter (current detection means or current measuring means)
4411 Checking driver (checking control means, source signal line selection means)
4441 Temperature sensor (temperature variation detecting means, temperature measuring means, temperature checking means)
4443 Detector
4491 Selection driver circuit
4681 Comparator (comparison means)
4682 Counter circuit
4711 Coincidence circuit
4881 Glass substrate
4891 Signal wiring
5041 Frame (field) memory
5111 Current output stage (program current output circuit)
5112 Pre-charge period determining portion
5131 Pre-charge pulse generating portion
Divider circuit (clock frequency conversion circuit, timing change circuit)
5133 Pulse generating portion (pre-charge pulse generation circuit, timing circuit)
5134 Decoder (including decoder having latch circuit)
5135 Selector
5191 Capacitor electrode
5192 Adder
5193 AD converter (analog-to-digital converter)
5201 Dummy pixel (Terminal detecting means, voltage detecting circuit)
5281 Comparator (signal level judging means)
5301 Processing circuit (signal processing circuit)
5311 Mode converter circuit (IC) (signal level conversion circuit)
5391 Coil (transformer)
5392 Control circuit
5393 Diodes (rectification means)
5394 Condenser (smoothing means)
5395 Resistor
5396 Transistor
5401 variable resistance
5411 Switch
5413 Power supply circuit
5451 Switch
5461 Resistance
5471 Sub-unit transistor
5601 Switch (connection means)
5602 (Analog) switch (conversion means)
5611 Selected unit transistor
3411 Pre-charge pulse
5721 Photosensor
5722 Decoder (bar-code decoder)
5723 EL display panel (self-luminous display panel (apparatus))
5861 Color filter (color improvement means, wave narrow band area means)
5871 Pixel anode wiring
5881 Thin metal film (conductive material)
3441 Wafer
3442 Characteristic distribution
5911 Doping head
5912 Laser head
6021 Anode wiring
6161 Isolation post (isolation wall (ring))
6162 Sealing resin (sealing means)
6163 Space

### BEST MODE FOR CARRYING OUT THE INVENTION

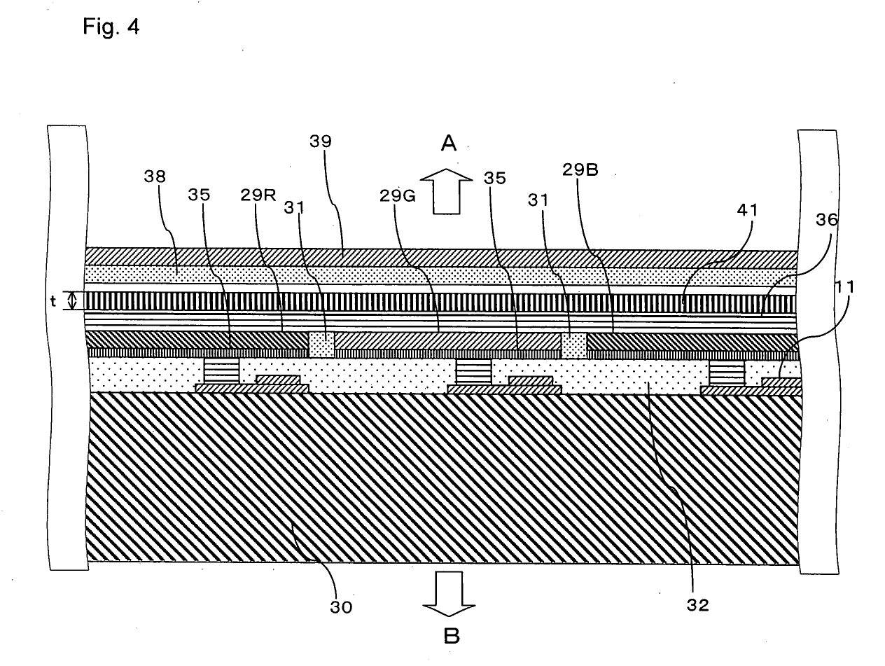

Some parts of drawings herein are omitted, enlarged or reduced herein for ease of understanding and illustration. For example, in a sectional view of a display panel shown in FIG. 4, a thin encapsulation film 41 and the like are shown as being fairly thick. On the other hand, in FIG. 3, a sealing lid 40 is shown as being thin. Some parts are omitted. For example, although the display panel according to the present invention requires a phase film (38, 39) such as a circular polarizing plate to prevent reflection, a circular polarizing plate or the like is omitted in drawings herein. This also applies to the drawings below. Besides, the same or similar forms, materials, functions, or operations are denoted by the same reference numbers or characters.

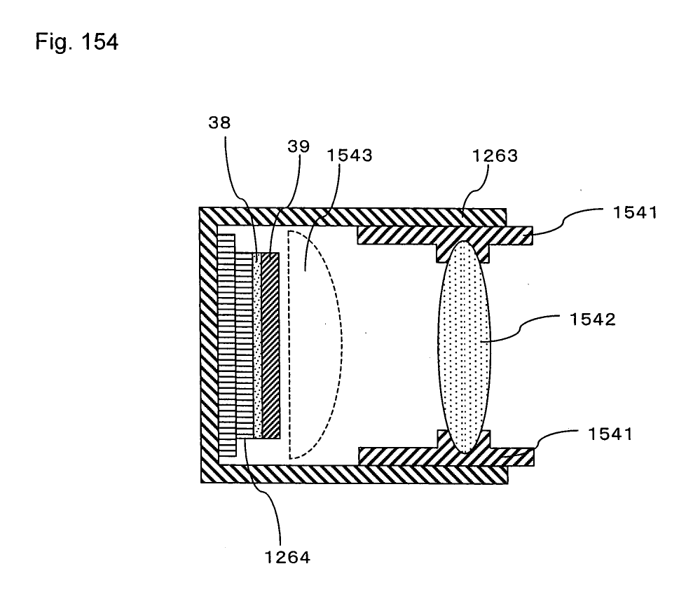

What is described with reference to drawings or the like can be combined with other examples or the like even if not noted specifically. For example, a touch panel or the like can be attached to a display panel in FIGS. 3 and 4 of the present invention to provide an information display apparatus shown in FIGS. 154 to 157.

Thin-film transistors are cited herein as driver transistors 11 and switching transistors 11, this is not restrictive. Thin-film diodes (TFDs) or ring diodes may be used instead. Also, the present invention is not limited to thin-film elements, and transistors formed on silicon wafers may also be used. Needless to say, FETs, MOS-FETs, MOS transistors, or bipolar transistors may also be used. They are basically, thin-film transistors. It goes without saying that the present invention may also use varistors, thyristors, ring diodes, photodiodes, phototransistors, or PLZT elements. That is, the transistor 11, gate driver circuit 12, and source driver circuit (IC) 14 according to the present invention can use any of the above elements.

A source driver circuit (IC) 14 may incorporate a power circuit, buffer circuit (including a circuit such as a shift register), data conversion circuit, latch circuit, command decoder, shifting circuit, address conversion circuit, image memory, etc, as well as a mere driver function.

Although it is assumed in the following description that the substrate 30 is a glass substrate, a silicon wafer may be used alternatively. Also, the substrate 30 may be a metal substrate, ceramic substrate, plastic sheet (plate), or the like. Needless to say, the transistors 11, gate driver circuits 12, source driver circuits (IC) 14, and the like may be formed on a glass substrate, and then transferred to another substrate (such as a plastic sheet). The same applies to the material or the configuration of the lid 40. Needless to say, sapphire glass may be used for the lid 40 and substrate 30 to improve heat dissipation characteristics.

An EL display panel according to the present invention will be described below with reference to drawings. As shown in FIG. 3, an organic EL display panel consists of a glass substrate 30 (array board 30), transparent electrodes 35 formed as pixel electrodes, at least one organic functional layer (EL layer) 29, and a metal electrode (reflective film) (cathode) 36, which are stacked one on top of another, where the organic functional layer consists of an electron transport layer, light-emitting layer, positive hole transport layer, etc. The organic functional layer (EL film) 29 emits light when a positive voltage is applied to the anode or transparent electrodes (pixel electrodes) 35 and a negative voltage is applied to the cathode or metal electrode (reflective electrode) 36, i.e., when a direct current is applied between the transparent electrodes 35 and metal electrode 36.

Incidentally, a desiccant 37 is placed in a space between the sealing lid 40 and array board 30. This is because the organic EL film 29 is vulnerable to moisture. The desiccant 37 absorbs water penetrating a sealant and thereby prevents deterioration of the organic EL film 29. The lid 40 and array board 30 have their periphery sealed with sealing resin 2511 as illustrated in FIG. 251.

The lid 40 is a means of preventing or reducing penetration of moisture and is not limited to a particular shape. For example, it may be made of a glass plate, plastic plate, or film. Also, the lid 40 may be made of fused glass. Alternatively, it may be formed of resin or inorganic material or made of a thin film (see FIG. 4) formed by vapor deposition technology.

As illustrated in FIG. 251, a speaker 2512 may be placed or formed between the sealing lid 40 and array board 30. For example, the speaker 2512 may be a thin film speaker used on mobile devices and the like. In a recess in the sealing lid 40, there is a space 2514, which can be used efficiently if the speaker 2512 is placed in it. The speaker 2512 vibrates in the space 2514 and thus the panel can be configured to produce sound from its surface. Of course, the speaker 2512 may be placed on the back surface (opposite to viewing surface) of the display panel. This provides a good acoustic device in which the speaker 2512 vibrates, resulting in vibration of the space 2514. The speaker 2512 can be either fastened together with the desiccant 37 or affixed securely to the sealing lid 40 at a location separate from the desiccant 37. Alternatively, the speaker 2512 may be formed directly on the sealing lid 40.

A temperature sensor (not shown) may be formed or placed in the space 2514 in the sealing lid 40 or on a surface of the sealing lid 40. Duty ratio control, reference current control, lighting ratio control, etc. (described alter) may be performed based on output from the temperature sensor.

Terminal wiring of the speaker 2512 is formed of deposited aluminum film on the substrate 30 or the like. The terminal wiring is connected to a power source or signal source outside the sealing lid 40.

A thin microphone may be placed or formed in a manner similar to the speaker 2512. Also, a piezooscillator may be used as a speaker. Needless to say, drive circuits for the speaker, microphone, etc. may be formed or placed directly on the array 30 using polysilicon technology.

Surfaces of the speaker 2512, microphone, etc. are sealed by vapor-depositing or applying a thin film or thick film 2513 made of one or more of organic material, inorganic material, or metallic material. The sealing reduces degradation of the organic EL film and the like caused by gas and the like released from the speaker. 2512 and the like.

One of the problems with EL display panels (EL display apparatus) is reduced contrast due to halation in the panel. The halation is caused by diffusion of light given off by the EL elements 15 (EL film 29) and trapped in the panel.

To solve this problem, in the EL display panel according to the present invention, a light-absorbing film (light-absorbing means) is formed in display areas unavailable for image display (ineffective areas). The light-absorbing film prevents display contrast from being reduced by the halation which occurs as the light emitted by the pixels 16 is diffused by the substrate 30.

Examples of the ineffective areas include flanks of the substrate 30 or sealing lid 40, non-display areas (e.g., areas in or around which gate driver circuits 12 or source driver circuits (IC) 14 are formed) on the substrate 30, and a entire surface of the sealing lid 40 (in the case of underside extraction).

Possible materials for light-absorbing films include, for example, organic material such as acrylic resin containing carbon, organic resin with a black pigment dispersed in it, and gelatin or case in colored with a black acidic dye as with a color filter. Besides, they also include a fluorine-based pigment which singly develops a black color as well as green and red pigments which develop a black color when mixed. Furthermore, they also include PrMnO3 film formed by sputtering, phthalocyanine film formed by plasma polymerization, etc.

Besides, metal materials may also be used for the light-absorbing films. Possible materials include, for example, hexavalent chromium. Hexavalent chromium is black in color and functions as a light-absorbing film. Besides, light-scattering materials such as opal glass and titanium oxide are also available. This is because it becomes equal to absorb light as a result of scattering light.

An organic EL display panel shown in FIG. 3 according to the present invention has an arrangement of encapsulation with cover 40 of glass. The present invention is not limited to this however. For example, encapsulation maybe achieved using a film 41 (thin film) as shown in FIG. 4. That is, it may have an encapsulating structure using 41 which is encapsulating thin film 41.

An example of the encapsulating film (encapsulating thin film) 41 is a film formed by vapor deposition of DLC (diamond-like-carbon) on a film for use in electrolytic capacitors. This film has very poor water permeability (i.e. high moisture proofness) and hence is used as the encapsulating film 41. It is needless to say that an arrangement in which a DLC (diamond-like carbon) film or the like is vapor-deposited directly over the electrode 36 can serve the purpose. Alternatively, the encapsulating thin film may comprise a multi-layered film formed by stacking a resin thin film and a metal thin film on the other.

The thickness of the thin film 41 or film used for sealing is not limited to the film thickness in the interference area. Needless to say, the film may be 5 to 10 μm or above, or 100 μm or above. If the thin film 41 used for sealing has transparency, side A in FIG. 4 corresponds to a light exit side and if the thin film 41 has an untransparent or reflective feature or structure, side B corresponds to a light exit side.

The EL display panel may be configured to emit light from both side A and side B. In that case, images viewed from side A and side B of the EL display panel are horizontally flipped images of each other. Thus, an EL display panel which is viewed from both side A and side B is equipped with a function to horizontally flip images either manually or automatically. To implement this function, one or more pixel rows of a video signal can be accumulated in a line memory and the reading direction of the line memory can be reversed.

A technique which uses an encapsulation film 41 for sealing instead of a sealing lid 40 as shown in FIG. 4 is called thin film encapsulation. In the case of “underside extraction (see FIG. 3; light is extracted in the direction of the arrow B in FIG. 3)” in which light is extracted from the side of the board 30, thin film encapsulation 41 involves forming an EL film and then forming an aluminum electrode which will serve as a cathode on the EL film. Then, a resin layer is formed as a cushioning layer on the aluminum layer. An organic material such as acrylic or epoxy may be used for a cushioning layer. Suitable film thickness is from 1 μm to 10 μm (both inclusive). More preferably, the film thickness is from 2 μm to 6 μm (both inclusive). The encapsulation film 74 is formed on the cushioning film.

Without the cushioning film, structure of the EL film would be deformed by stress, resulting in streaky defects. As described above, the encapsulation film 41 may be made, for example, of DLC (diamond-like carbon) or an electrolytic capacitor of a laminar structure (structure consisting of thin dielectric films and aluminum films vapor-deposited alternately).

In the case of “topside extraction (see FIG. 4; light is extracted in the direction of the arrow A in FIG. 4)” in which light is extracted from the side of the organic EL film 29, thin film encapsulation involves forming the organic EL film 29 and then forming an Ag—Mg film 20 angstrom (inclusive) to 300 angstrom thick on the organic EL film 29 to serve as a cathode (or anode). A transparent electrode such as ITO is formed on the film to reduce resistance. Preferably, a resin layer is formed as a cushioning layer on the electrode film. An encapsulation film 41 is formed on the cushioning film.

In FIG. 3 or the like, half the light produced by the organic EL film 29 is reflected by the reflected film (cathode electrode) 36 and emitted through the array board 30. However, the reflected film (cathode electrode) 36 reflects extraneous light, resulting in glare, which lowers display contrast. To deal with this situation, a λ/4 plate (phase film) 38 and polarizing plate (polarizing film) 39 are placed on the array board 30. The plate made of a polarizing plate 39 and a phase film 38 is called circular polarizing plate (circular polarizing sheet).

In the configuration in FIG. 3 or 4, display brightness can be improved if minute triangular or quadrangular prisms are formed on the light exit surface. In the case of quadrangular prisms, the sides of the bottom face should be between 10 and 100 μm (both inclusive). Preferably, they should be between 10 and 30 μm (both inclusive). In the case of triangular prisms, the diameter of the bottom side should be between 10 and 100 μm (both inclusive). Preferably, it should be between 10 and 30 μm (both inclusive).

If the pixels 16 are reflective electrodes, the light produced by the organic EL film 29 is emitted upward (light is emitted in the direction A in FIG. 4). Thus, needless to say, the phase plate 38 and polarizing plate 39 are placed on the side from which light is emitted.

Reflective pixels 16 can be obtained by making pixel electrodes 35 from aluminum, chromium, silver, or the like. Also, by providing projections (or projections and depressions) on a surface of the pixel electrodes 35, it is possible to increase an interface with the organic EL film 29, and thereby increase the light-emitting area, resulting in improved light-emission efficiency. Incidentally, the reflective film which serves as the cathode 36 (anode 35) is made as a transparent electrode. If reflectance can be reduced to 30% or less, no circular polarizing plate is required. This is because glare is reduced greatly. Light interference is reduced as well.

The use of diffraction grating as the projections (or projections and depressions) is effective in deriving light. The diffraction grating should have a two- or three-dimensional structure. The pitch of the diffraction grating is preferably between 0.2 μm and 2 μm (both inclusive). This range provides good optical efficiency. More preferably, it is between 0.3 μm and 0.8 μm (both inclusive). Also, the diffraction grating is preferably sinusoidal.

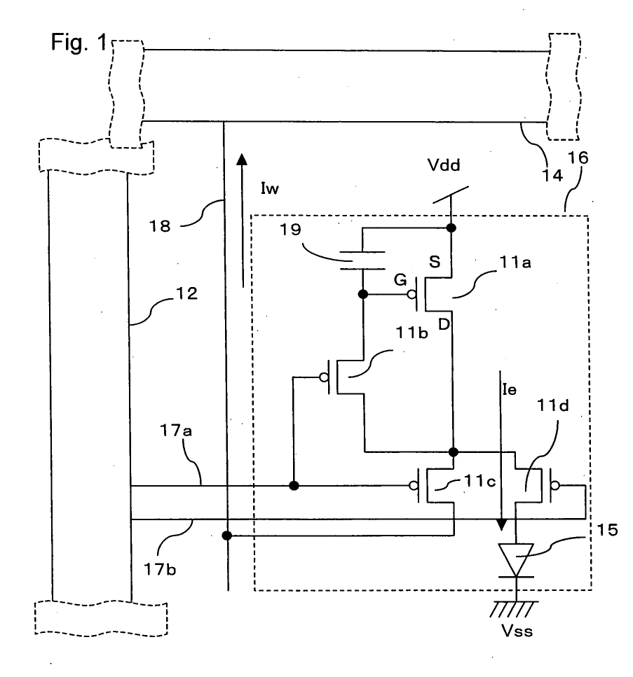

In FIG. 1 or the like, transistor 11 is preferably structured in LDD (lightly doped drain).

Masked vapor deposition is used for colorization of EL display apparatus, but the present invention is not limited to this. For example, it is alternatively possible to form a blue light emitting EL layer and convert the emitted blue light into R, G, and B colors using R, G, and B conversion layers (CCM: color change media). For example, in FIG. 4, color filters are placed on or under the thin film 41. Of course, an uchiwake method of RGB organic materials (EL materials) using precision shadow-masking may be used. The EL display panel according to the present invention may use any of the above methods.

Each structure of pixel 16 in an EL panel (EL display apparatus) according to the present invention comprises four transistors 11 and an EL element 15 as shown in FIG. 1 and the like. Pixel electrodes 35 are configured to overlap with a source signal line 18. A planarized film 32, which consists of an insulating film or an acrylic material, is formed on the source signal line 18 for insulation and the pixel electrode 35 is formed on the planarized film 32. A structure in which pixel electrodes 35 overlap with at least part of the source signal line 18 is known as a high aperture (HA) structure. This reduces unnecessary light interference and allows proper light emission.

The planarized film 32 also acts as an interlayer insulating film. The planarized film 32 is formed or configured to have a thickness of 0.4 to 2.0 μm (both inclusive). A film thickness of 0.4 or less tends to cause poor layer insulation (resulting in a reduced yield). A film thickness of 2.0 μm or more makes it difficult to form a contact connector 34, often causing a poor contact (resulting in a reduced yield).

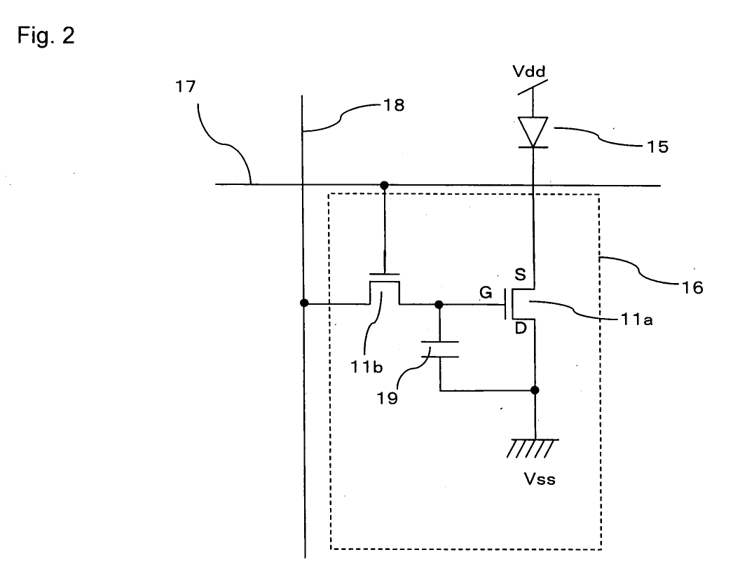

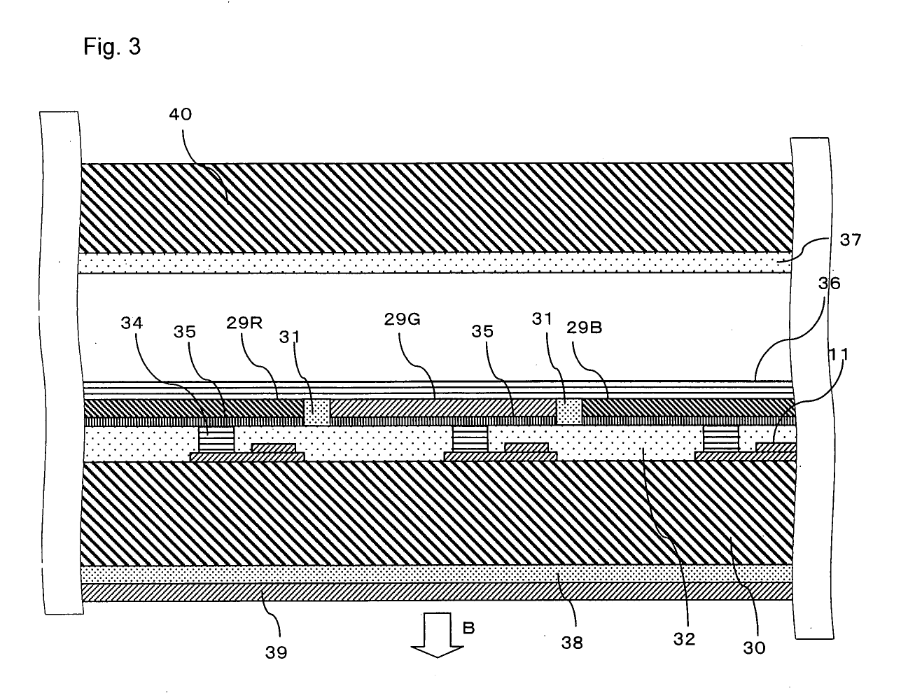

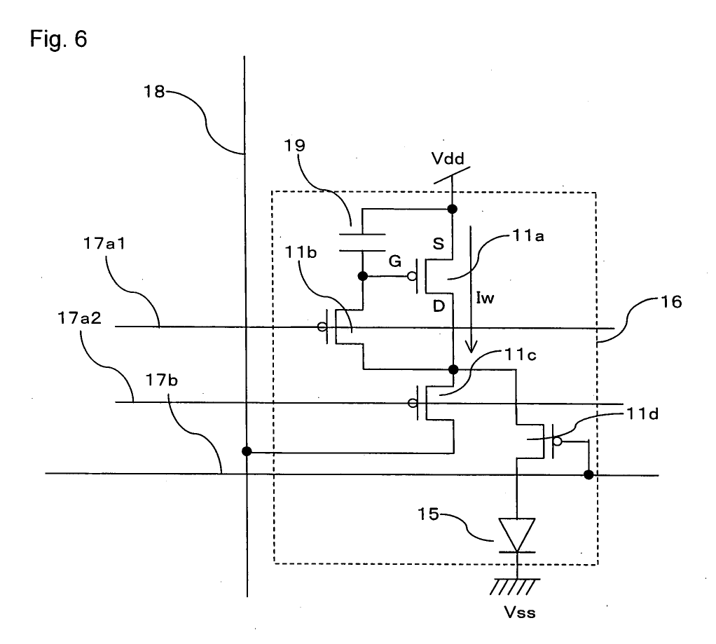

Although the pixel configuration of the EL display panel according to the present invention is described with reference to FIG. 1, this is not restrictive. Needless to say, the present invention is also applicable, for example, to the pixel configurations in FIG. 2, FIGS. 6 to 13, FIG. 28, FIG. 31, FIGS. 33 to 36, FIG. 158, FIGS. 193 to 194, FIG. 574, FIG. 576, FIGS. 578 to 581, FIG. 595, FIG. 598, FIGS. 602 to 604, and FIGS. 607(a), 607(b), and 607(c).

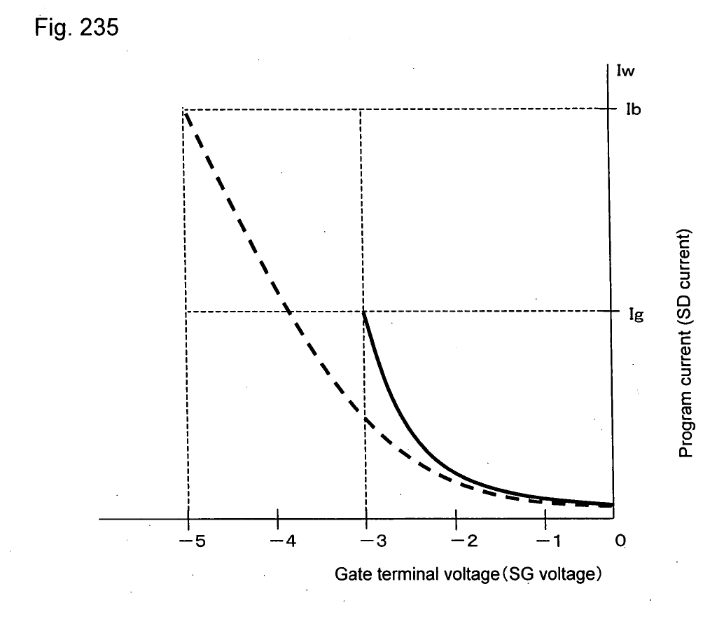

On EL display panels, luminous efficiency often varies among R, G, and B. Consequently, the current flowing through the driver transistor 11a varies among R, G, and B. For example, in FIG. 235, a driver transistor 11a which drives a B pixel 16 is indicated by a broken line while a driver transistor 11a which drives a G pixel 16 is indicated by a solid line. The vertical axis in FIG. 235 represents a current (S-D current) (μA) passed by the driver transistor 11a, i.e., the programming current Iw while the horizontal axis represents a gate terminal voltage of the driver transistor 11a.

As illustrated in FIG. 235, if the S-D current at a gate terminal voltage varies in magnitude among R, G, and B, the accuracy of current (voltage) programming decreases (the accuracy of the characteristic indicated by the solid line in FIG. 235 decreases). To deal with this problem, the WL ratio, i.e., the ratio between the channel width (W) and channel length (L) is adjusted during the design of the driver transistor 11a. Preferably, regarding the design of the transistor 11a, the S-D currents outputted by the R, G, and B driver transistors at the same gate terminal voltage do not differ from each other by more than twice.

The EL elements 15 will be described herein taking organic EL elements (known by various abbreviations including OEL, PEL, PLED, OLED) as an example, but this is not restrictive and inorganic EL elements may be used as well.

An organic EL display panel of active-matrix type must satisfy two conditions: that it is capable of selecting a specific pixel and give necessary display information and that it is capable of passing current through the EL element throughout one frame period.

To satisfy the two conditions, in a conventional organic EL pixel configuration shown in FIG. 2, a switching transistor is used to be functioned as a first transistor 11b to select the pixel. And a driver transistor is used to be functioned as a second transistor 11a to supply current to an EL element 15.

To display a gradation using this configuration, a voltage corresponding to the gradation must be applied the gate of the driver transistor 11a. Consequently, variations in a turn-on current of the driver transistor 11a appear directly in display.

The turn-on current of a transistor is extremely uniform if the transistor is monocrystalline. However, in the case of a low-temperature polycrystalline transistor formed on an inexpensive glass substrate by low-temperature polysilicon technology at a temperature not higher than 450, its threshold varies in a range of ±0.2 V to 0.5 V. The turn-on current flowing through the driver transistor 11a varies accordingly, causing display irregularities. The irregularities are caused not only by variations in the threshold voltage, but also by mobility of the transistor and thickness of a gate insulating film. Characteristics also change due to degradation of the transistor 11.

This phenomenon is not limited to low-temperature polysilicon technologies, and can occur in transistors formed on semiconductor films grown in solid-phase (CGS) by high-temperature polysilicon technology at a process temperature of 450 degrees (centigrade) or higher. Besides, the phenomenon can occur in organic transistors and amorphous silicon transistors.

In a method which displays gradations by the application of voltage as shown in FIG. 2, device characteristics must be controlled strictly to obtain a uniform display. However, current low-temperature polycrystalline polysilicon transistors or the like cannot keep the variations within a predetermined range.

Transistor 11 which composes a pixel 16 of the display panel in the present invention is composed by p-channel polysilicon thin-film transistor. And the transistor 11b is a dual-gate or multi-gate transistor.

The transistor 11b which composes a pixel 16 of the display panel in the present invention acts for the transistor 11a as a source-drain switch. Accordingly, as high an ON/OFF ratio as possible is required of transistor 11b. By using a dual-gate or multi-gate structure for the transistor 11b, it is possible to achieve a high ON/OFF ratio.

The semiconductor films composing the transistors 11 in the pixel 16 are generally formed by laser annealing in low-temperature polysilicon technology. Variations in laser annealing conditions result in variations in transistor 11 characteristics. However, if the characteristics of the transistors 11 in the pixel 16 are consistent, it is possible to drive the pixel using current programming so that a predetermined current will flow through the EL element 15. This is an advantage lacked by voltage programming. Preferably the laser used is an excimer laser.

Incidentally, the semiconductor film formation according to the present invention is not limited to the laser annealing method. The present invention may also use a heat annealing method and a method which involves solid-phase (CGS) growth. Besides, the present invention is not limited to the low-temperature polysilicon technology and may use high-temperature polysilicon technology. Also, the semiconductor films may be formed by amorphous silicon technology.

The present invention moves a laser spot (lined laser irradiation range) in parallel to the source signal line 18. Also, the laser spot is moved in such a way as to align with one pixel row. Of course, the number of pixel rows is not limited to one. For example, laser may be shot by treating RGB pixel (three pixel columns in this case) as a single pixel. Also, laser may be directed at two or more pixels at a time. Needless to say, moving laser irradiation ranges may overlap (it is usual for moving laser irradiation ranges to overlap).

By making the linear laser spot coincide with the formation direction of the source signal line 18 (by aligning the formation direction of the source signal line 18 in parallel to the longer dimension of the laser spot) during laser annealing, the characteristics (mobility, Vt, S value, etc.) of the transistors 11 connected to the same source signal line 18 can be made uniform.

Pixels are constructed in such a way that three pixels of RGB will form a square shape. Thus, each of the R, G, B pixels has oblong shape. Consequently, by performing annealing using an oblong laser spot, it is possible to eliminate variations in the characteristics of the transistors 11 within each pixel. Incidentally, the pixel aperture ratio may be varied among R, G, and B pixels. By varying the aperture ratio, it is possible to vary the density of the current flowing through the EL pixels 15 among R, G, and B. Varying the current density makes it possible to equalize degradation rates of the EL pixels 15 for R, G, and B. Equal degradation rates prevent the white balance of the EL display apparatus from being upset.

Characteristic distribution (variations in the characteristics) of the driver transistors 11a on the array board 30 can occur even in a doping process. As illustrated in FIG. 591(a), holes for doping are provided at equal intervals in a doping head 5911. Characteristic distribution due to doping appears in a streak form as illustrated in FIG. 591(a).

In the manufacturing method according to the present invention, the direction of the characteristic distribution due to doping (FIG. 591), the direction of characteristic distribution due to laser annealing (FIG. 592), and the formation direction of the source signal line 18 (FIG. 593) are made to coincide as illustrated in FIG. 591. This configuration (formation) makes it possible to properly correct variations in the characteristics of the transistors 11a in current driving mode by current programming.

In the doping process in FIG. 591, characteristic distribution occurs in the scanning direction of the doping head 3461 (in the direction perpendicular to the doping head). In the laser annealing process in FIG. 592, characteristic distribution occurs in the direction perpendicular to the scanning direction of a laser head 3462 (the characteristic distribution occurs along the longer dimension of the doping head). This is because laser annealing occurs linearly with a linear laser light directed at the substrate 30. That is, laser shots are placed linearly while shifting the laser irradiation site in sequence to laser-anneal the entire substrate 30.

As illustrated in FIG. 593, the longer dimension of the laser head 5912 is parallel to the source signal line 18 (the linear laser light is directed in parallel to the source signal line 18). Also, as illustrated in FIG. 591, the doping head 5911 is placed and manipulated in vertical to the source signal line 18 (doping is performed such that the direction of the characteristic distribution due to the doping will be parallel to the source signal line 18).

Also, as illustrated in FIG. 594, the driver transistor 11a of the pixel 16 is formed or placed in such a way that the longer dimension (the longer of sides a and b when the channel area is given by a×b) of the transistor 11a will coincide with the direction of the laser head 5912 (that the longer dimension of the channel of the transistor 11a will be perpendicular to the scanning direction of the laser head 5912). This is because the channel of the transistor 11a is annealed by a single laser shot, resulting in reduced variations in the characteristics. Also, the transistor 11a is formed or placed in such a way that the longer dimension of the channel of the transistor 11a will be parallel to the source signal line 18. The manufacturing method according to the present invention performs the doping process after the laser annealing process.

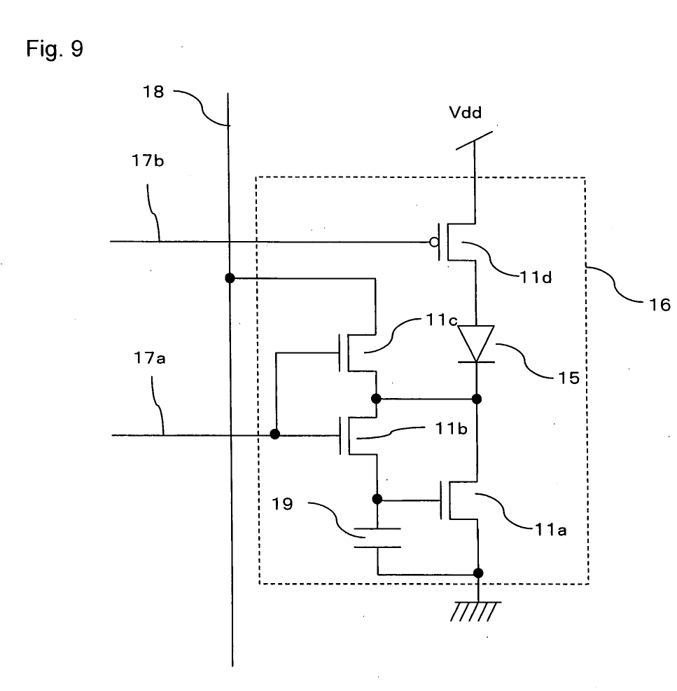

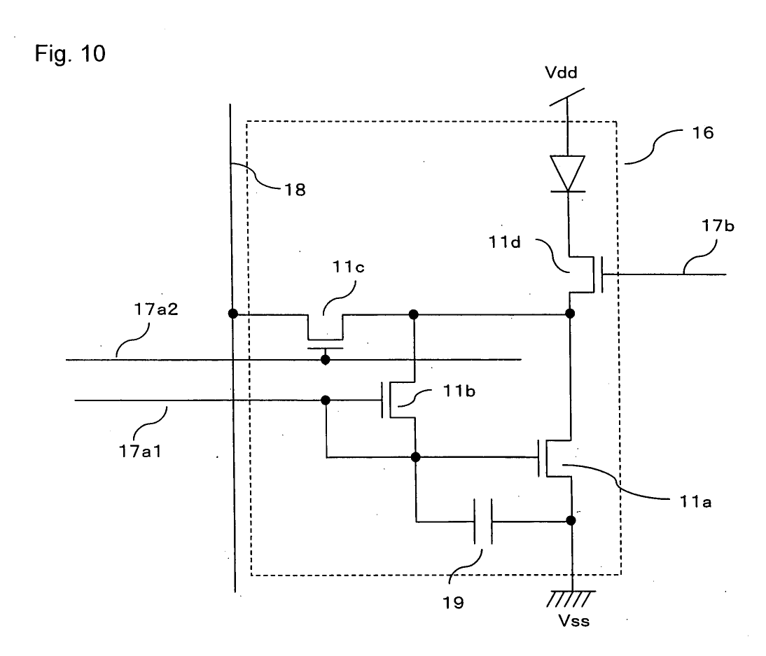

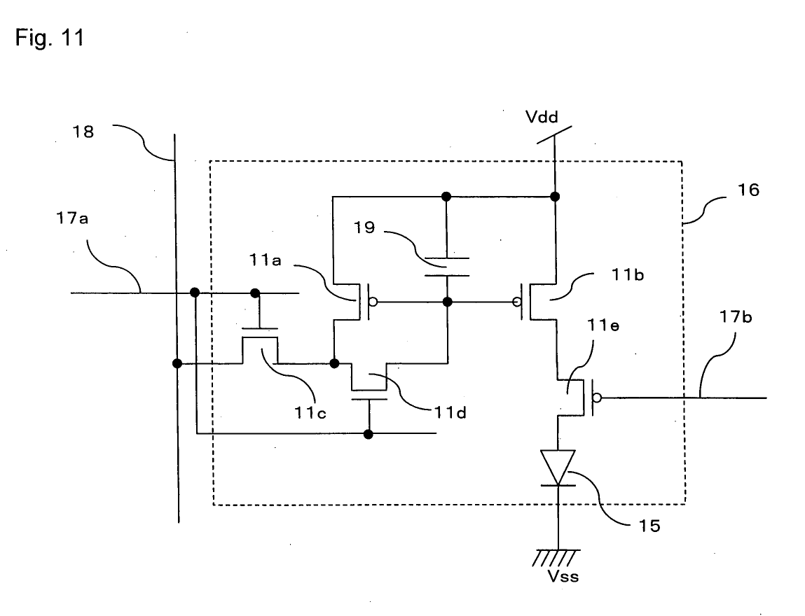

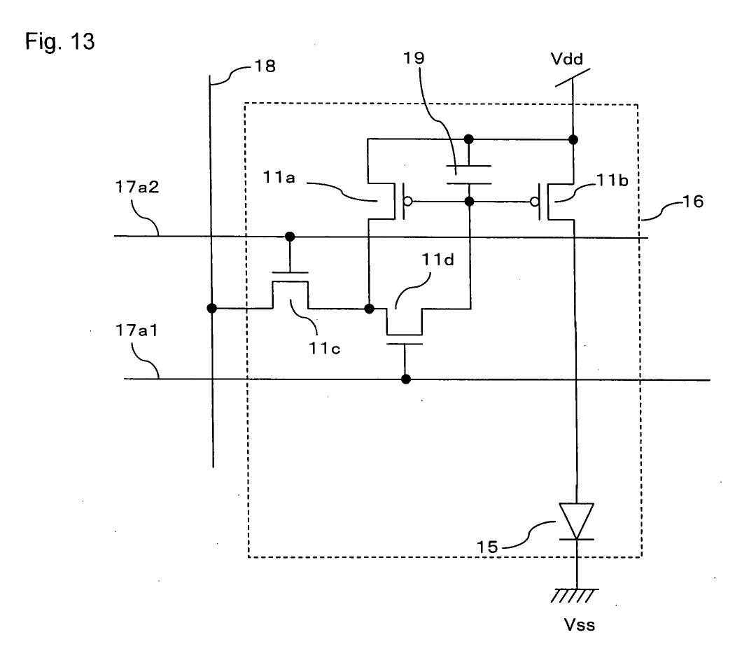

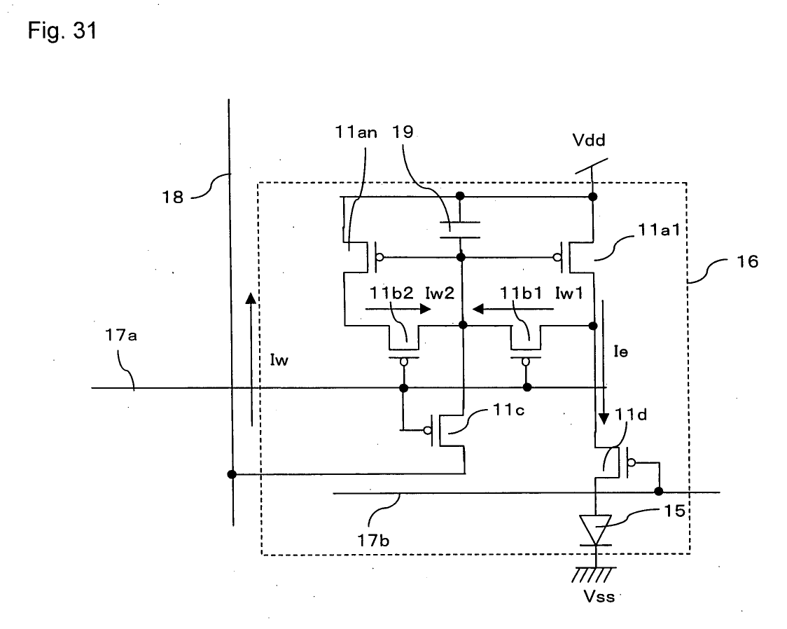

Needless to say, the above described manufacturing direction or the configuration is also applicable, for example, to the pixel configurations in FIG. 2, FIG. 9, FIG. 10, FIG. 13, FIG. 31, FIG. 11, FIG. 602, FIG. 603, FIG. 604, FIGS. 607(a), 607(b), and 607(c), and the like.

The unit transistors 154 of the source driver circuit (IC) 16 according to the present invention needs to have a certain area. One of the reasons why the unit transistors 154 must have a certain transistor size is that a wafer 5891 has a mobility distribution. FIG. 589 conceptually shows characteristic distribution of the wafer 5891. Generally, characteristic distribution 5892 of the wafer 5891 has a stripe pattern (streaky pattern). The characteristics of the parts represented by the strips are similar to each other.

To improve the characteristic distribution 5892, an IC process in a diffusion process is designed ingeniously. It is useful to run the same diffusion process multiple times. In the diffusion process, doping and the like are scanned. The scanning varies the characteristics (especially Vt) of the unit transistors periodically. Thus, by running the diffusion process multiple times and shifting the start position in each iteration of the diffusion process, it is possible to average the characteristic distribution of the transistors. This reduces periodic irregularities. Without these procedures, characteristic distribution of the transistors is usually striped at intervals of 3 to 5 mm. It is appropriate to shift scans by 1 to 2 mm multiple times.

In the manufacturing method of the source driver circuit (IC) 14 according to the present invention, the diffusion process which sets or determines the mobility of the transistors in the source driver circuit (IC) 14 is divided into multiple segments or repeated multiple times. These procedures provide an effective or characteristic manufacturing method of the current-output type source driver circuit (IC) 14.

It is also useful to work out an ingenuous layout for the source driver circuit (IC) 14. The source driver IC chip 14 should be laid out along the characteristic distribution 5892 as illustrated in FIG. 590(b) rather than as illustrated in FIG. 590(a). That is, a reticle for the IC chip is laid out such that the longer dimension of the IC chip will coincide with the direction of the characteristic distribution 5892 of the wafer 5891.

With the characteristic distribution 5892 shown in FIG. 589, there are less variations in characteristics among terminals 155 when the unit transistors 154 in a transistor group 431c are placed in a distributed manner as illustrated in FIG. 551(b) than when they are placed in an orderly manner as illustrated in FIG. 551(a). Incidentally, in FIG. 551, the unit transistors 154 hatched in the same manner form the transistor group 431c.

Variations in the characteristics of the unit transistors 154 depend on the output current of the transistor group 431c. The output current in turn depends on the efficiency of the EL elements 15. For example, the programming current outputted from the output terminal 155 for the G color decreases with increases in the luminous efficiency of the EL elements 15 for the G color. Conversely, the programming current outputted from the output terminal 155 for the B color increases with decreases in the luminous efficiency of the EL elements 15 for the B color.

The decreased programming current means decreases in the current outputted by the unit transistors 154. The decreased current results in increased variations in the unit transistors 154. To reduce the variations in the unit transistors 154, the size of the transistors can be increased.

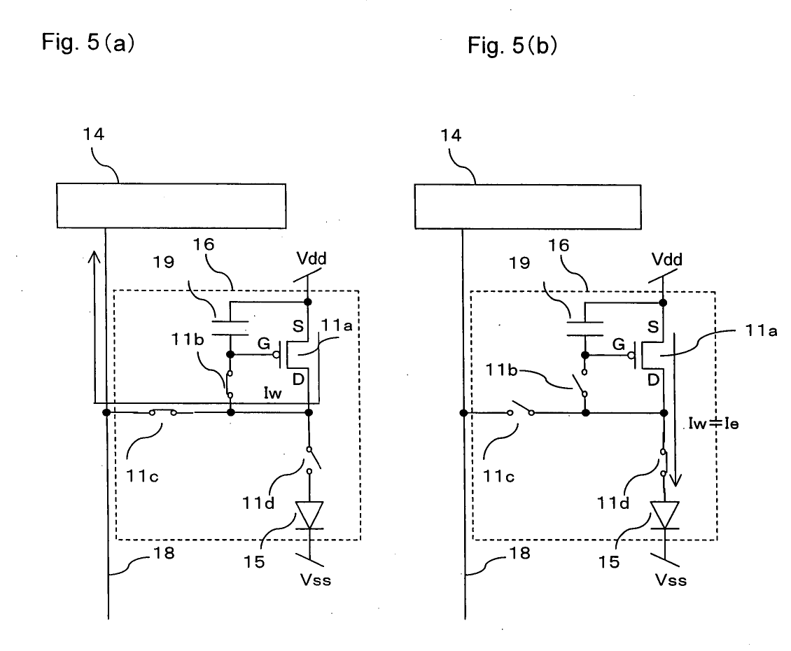

The pixel configuration of the EL display panel or the like shown in FIG. 1 of the present invention will be described below. The gate signal line (first scanning line) 17a is activated (a turn-on voltage is applied) At the same time, a program current Iw to be passed through the EL element 15 is delivered from the source driver circuit (IC) 14 to the driver transistor 11a via the switching transistor 11c. Also, the transistor 11b drives to cause a short circuit between gate terminal (G) and drain terminal (D) of the driver transistor 11a. At the same time, gate voltage (or drain voltage) of the transistor 11a is stored in a capacitor (storage capacitance, additional capacitance) 19 connected between the gate terminal (G) and drain terminal (S) of the transistor 11a (see FIG. 5(a)).

Preferably, the capacitor (storage capacitance) 19 should be from 0.2 pF to 2 pF both inclusive. More preferably, the capacitor (storage capacitance) 19 should be from 0.4 pF to 1.2 pF both inclusive.

Preferably, the capacity of the capacitor 19 is determined taking pixel size into consideration. The capacity needed for a single pixel is Cs (pF) and an area occupied by the pixel is Sp (square μm). Sp is not an aperture ratio.

Sp is an area occupied by a single R, G, or B pixel. For example, if an R pixel measures 200 μm×67 μm, Sp=13400 square μm.

If it is Sp (square μm), a condition 1500/Sp≦Cs≦30000/Sp, and more preferably a condition 3000/Sp≦Cs≦15000/Sp should be satisfied. Since gate capacity of the transistor 11 is small, Q as referred to here is the capacity of the storage capacitance (capacitor) 19 alone. If Cs is smaller than 1500/Sp, penetration voltage of the gate signal lines 17 has a greater impact and voltage retention decreases, causing luminance gradient and the like to appear. Also, compensation performance of TFTs is degraded. If Cs is larger than 30000/Sp, the aperture ratio of the pixel 16 decreases. Consequently, electric field density of the EL element increases, causing adverse effects such as reduction in the life of the EL element. Also, write time for current programming is increased due to the capacitance of the capacitor, resulting in insufficient writing in a low gradation region.

Also, if the capacitance value of the storage capacitance 19 is Cs and the turn-off current value of the second transistor 11b is Ioff, preferably the following equation is satisfied.
3<Cs/Ioff<24

More preferably the following equation is satisfied.
6<Cs/Ioff<18

By setting the turn-off current of the transistor 11b to 5 pA or less, it is possible to reduce changes in the current flowing through the EL to 2% or less. This is because when leakage current increases, electric charges stored between the gate and source (across the capacitor) cannot be held for one field with no voltage applied. Thus, the larger the storage capacity of the capacitor 19 becomes, the larger the permissible amount of the turn-off current. By satisfying the above equation, it is possible to reduce fluctuations in current values between adjacent pixels to 2% or less.

The foregoing related to the accumulated capacitance Cs or the like is not limited to the pixel configuration of FIG. 1 and may also apply to other pixel configurations of current programming, nonetheless.

During the luminous period of the EL element 15, the gate signal line 17a is deactivated (a turn-off voltage is applied) and a gate signal line 17b is activated. By switching a path where the program current IW=Ie flows to a path where the EL element 15 connects, it is programmed to deliver the stored program current Iw to the EL element 15 (see FIG. 5(b)).

In the pixel circuit of FIG. 1, a single pixel contains four transistors 11. The gate terminal of the driver transistor 11a is connected to the source terminal of the transistor 11b. The gate terminals of the transistors 11b and 11c are connected to the gate signal line 17a. The drain terminal of the transistor 11b is connected to the source terminal of the transistor 11c and source terminal of the transistor 11d. The drain terminal of the transistor 11c is connected to the source signal line 18. The gate terminal of the transistor 11d is connected to the gate signal line 17b and the drain terminal of the transistor 11d is connected to the anode electrode of the EL element 15.

All the transistors in FIG. 1 are P-channel transistors. Compared to N-channel transistors, P-channel transistors have more or less lower mobility, but they are preferable because they are more resistant to voltage and degradation. However, the EL element according to the present invention is not limited to P-channel transistors and the present invention may employ N-channel transistors alone. Also, the present invention may employ both N-channel and P-channel transistors.

In order to produce the panel cost effectively, P-channel transistors should be used for all the transistors 11 composing pixels as well as for the built-in gate driver circuits 12. By composing an array solely of P-channel transistors, it is possible to reduce the number of masks to 5, resulting in low costs and high yields.

To facilitate understanding of the present invention, the configuration of the EL element according to the present invention will be described below with reference to FIG. 5. The EL element according to the present invention is controlled using two timings. The first timing is the one when required current values are stored. Turning on the transistor 11b and transistor 11c with this timing provides an equivalent circuit shown in FIG. 5(a). A predetermined current Iw is applied from signal lines. This makes the gate and drain of the transistor 11a connected, allowing the current Iw to flow through the transistor 11a and transistor 11c. Thus, the gate-source voltage of the transistor 11a is such that allows I1 to flow.

The second timing is the one when the transistor 11a and transistor 11c are closed and the transistor 11d is opened. The equivalent circuit available at this time is shown in FIG. 5(b). The source-gate voltage of the transistor 11a is maintained. In this case, since the transistor 11a always operates in a saturation region, the current Iw remains constant.

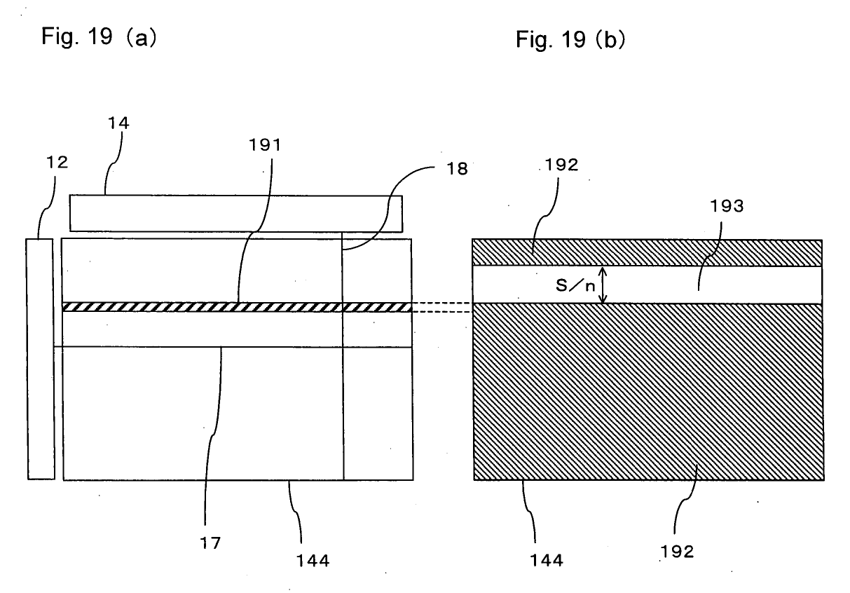

Results of this operation are shown in FIG. 19. Reference numeral 191a in FIG. 19(a) denotes a pixel (row) (write pixel row) programmed with current at a certain time point in a display screen 144. The pixel row 191a is non-illuminated (non-display pixel (row)) as illustrated in FIG. 5(b).

In the pixel configuration in FIG. 1, the programming current Iw flows through the source signal line 18 during current programming as shown in FIG. 5(a). The current Iw flows through the driver transistor 11a and voltage is set (programmed) in the capacitor 19 in such a way as to maintain the program current Iw. At this time, the transistor 11d is open (off).

During a period when the current flows through the EL element 15, the transistors 11c and 11b turn off and the transistor 11d turns on as shown in FIG. 5(b). Specifically, a turn-off voltage (Vgh) is applied to the gate signal line 17a, turning off the transistors 11b and 11c. On the other hand, a turn-on voltage (Vgl) is applied to the gate signal line 17b, turning on the transistor 11d.

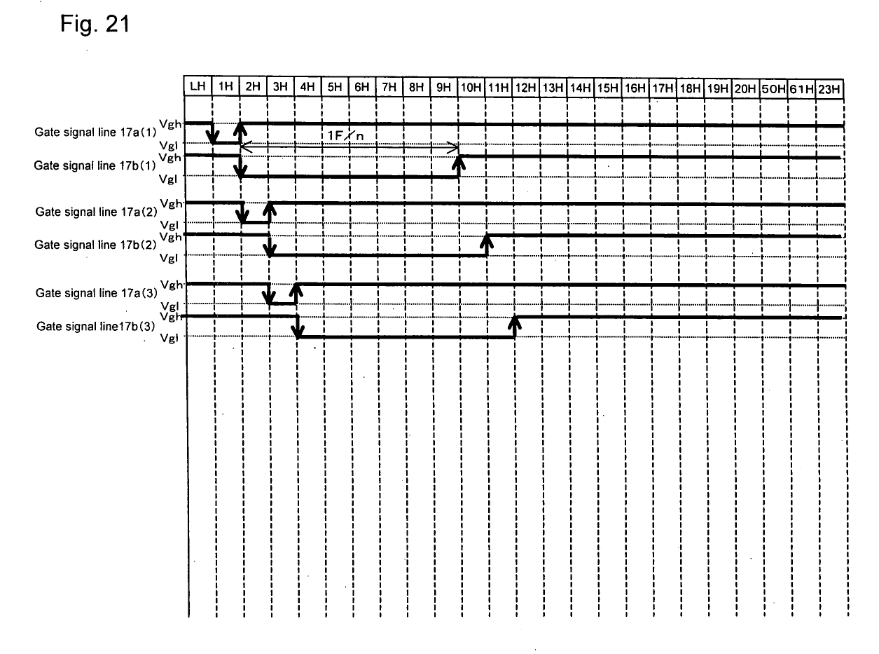

A timing chart is shown in FIG. 21. The subscripts in brackets in FIG. 21 (e.g., (1)) indicate pixel row numbers. Specifically, a gate signal line 17a (1) denotes a gate signal line 17a in a pixel row (1). Also, *H (where “*” is an arbitrary symbol or numeral and indicates a horizontal scanning line number) in the top row in FIG. 4 indicates a horizontal scanning period. Specifically, 1H is a first horizontal scanning period. Incidentally, the items (1H number, 1-H cycle, order of pixel row numbers, etc.) described above are intended to facilitate explanation and are not intended to be restrictive.

As can be seen from FIG. 21, in each selected pixel row (it is assumed that the selection period is 1 H), when a turn-on voltage is applied to the gate signal line 17a, a turn-off voltage is applied to the gate signal line 17b. During this period, no current flows through the EL element 15 (non-illuminated). In non-selected pixel rows, a turn-off voltage is applied to the gate signal line 17a and a turn-on voltage is applied to the gate signal line 17b.

Incidentally, the gate of the transistor 11a and gate of the transistor 11c are connected to the same gate signal line 11a. However, the gate of the transistor 11a and gate of the transistor 11c may be connected to different gate signal lines 11 (see FIG. 6). In FIG. 6, one pixel will have three gate signal lines (two in the configuration in FIG. 1).

In the pixel configuration in FIG. 6, by controlling ON/OFF timing of the gate of the transistor 11b and ON/OFF timing of the gate of the transistor 11c separately, it is possible to further reduce variations in the current value of the EL element 15 due to variations in the transistor 11a.

In the pixel configuration in FIG. 6, when the current programming is conducted to the pixel 16, gate signal lines 17a1 and 17a2 are selected at the same time, turning on the transistor 11b and 11c. Turn-off voltage is applied to the gate signal line 17b of the pixel 16 which is conducting the current programming turning off the transistor 11d.

To complete a current programming period (normally, one horizontal scanning period) in a selected pixel row, a turn-off voltage (Vgh) is applied to the gate signal line 17a1, turning off the transistor 11b. At this time, a turn-on voltage (Vgl) is applied to the gate signal line 17a2 and the transistor 11c remains on. Then, a turn-off voltage (Vgh) is applied to the gate signal line 17a2, turning off the transistor 11c.

Thus, when both transistors 11b and 11c are in on state, to turn off both transistors 11b and 11c (to finish a current programming period of the given pixel row), first the transistor 11b is turned off, breaking the connection between the gate terminal (G) and drain terminal (D) of the driver transistor 11a (a turn-off voltage (Vgh) is applied to the gate signal line 17a1). Next, the transistor 11c is turned off, disconnecting the drain terminal (D) of the driver transistor 11a from the source signal line 18 (a turn-off voltage (Vgh) is applied to the gate signal line 17a2 as well).

Preferably, the interval Tw between the time when a turn-off voltage is applied to the gate signal line 17a1 and the time when a turn-off voltage is applied to the gate signal line 17a2 is between 0.1 and 10 μsec (both inclusive). Preferably, it is between 0.1 and 10 μsec (both inclusive). Alternatively, if 1 H is Th, Tw is preferably between Th/500 and Th/10 (both inclusive). More preferably, Tw is between Th/200 and Th/50 (both inclusive).

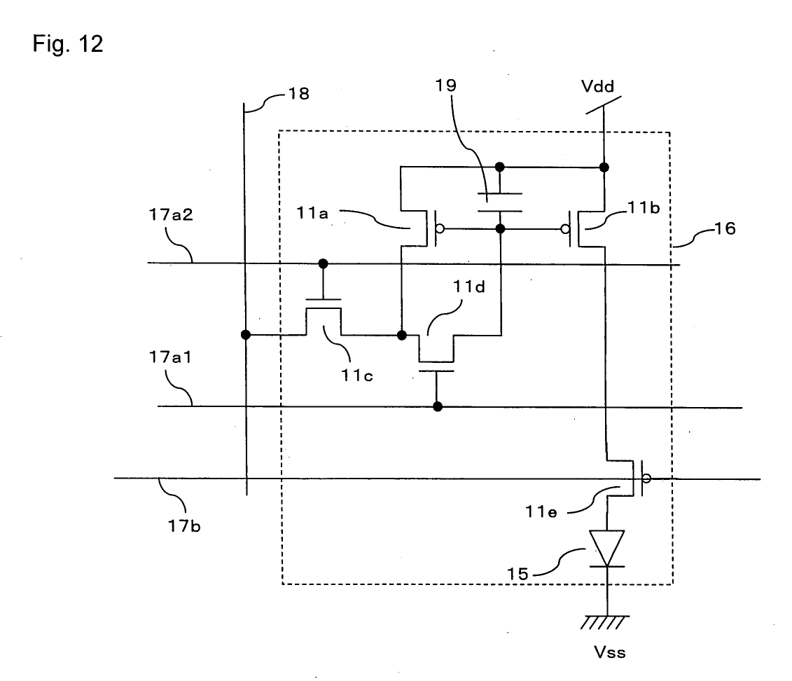

The foregoing is not remitted to the pixel configuration in FIG. 6. For example, it may apply to the pixel configurations in FIG. 12 or the like. In the pixel configuration in FIG. 12, when the current programming is conducted to the pixel 16, gate signal lines 17a1 and 17a2 are selected at the same time, turning on the transistor 11d and 11c. Turn-off voltage is applied to the gate signal line 17b of the pixel 16 which is conducting the current programming turning off the transistor 11e.

To complete a current programming period (normally, one horizontal scanning period) in a selected pixel row, a turn-off voltage (Vgh) is applied to the gate signal line 17a1, turning off the transistor 11d. At this time, a turn-on voltage (Vgl) is applied to the gate signal line 17a2 and the transistor 11c remains on. Then, a turn-off voltage (Vgh) is applied to the gate signal line 17a2, turning off the transistor 11c.

Thus, when both transistors 11d and 11c are in on state, to turn off both transistors 11d and 11c (to finish a current programming period of the given pixel row), first the transistor 11d is turned off, breaking the connection between the gate terminal (G) and drain terminal (D) of the driver transistor 11a (a turn-off voltage (Vgh) is applied to the gate signal line 17a1). Next, the transistor 11c is turned off, disconnecting the drain terminal (D) of the driver transistor 11a from the source signal line 18 (a turn-off voltage (Vgh) is applied to the gate signal line 17a2 as well).

Just like in FIG. 6, the interval Tw between the time when a turn-off voltage is applied to the gate signal line 17a1 and the time when a turn-off voltage is applied to the gate signal line 17a2 is preferably between 0.1 and 10 μsec (both inclusive) in FIG. 12. Preferably, it is between 0.1 and 10 μsec (both inclusive). Alternatively, if 1 H is Th, Tw is preferably between Th/500 and Th/10 (both inclusive). More preferably, Tw is between Th/200 and Th/50 (both inclusive).

It is not needless to say that the foregoing may apply to the pixel configurations in FIG. 10 or the like. Also, switching transistor lie may be omitted as shown in FIG. 13 although switching transistor 11e is placed between the driver transistor 11b and the EL element 15 in FIG. 12.

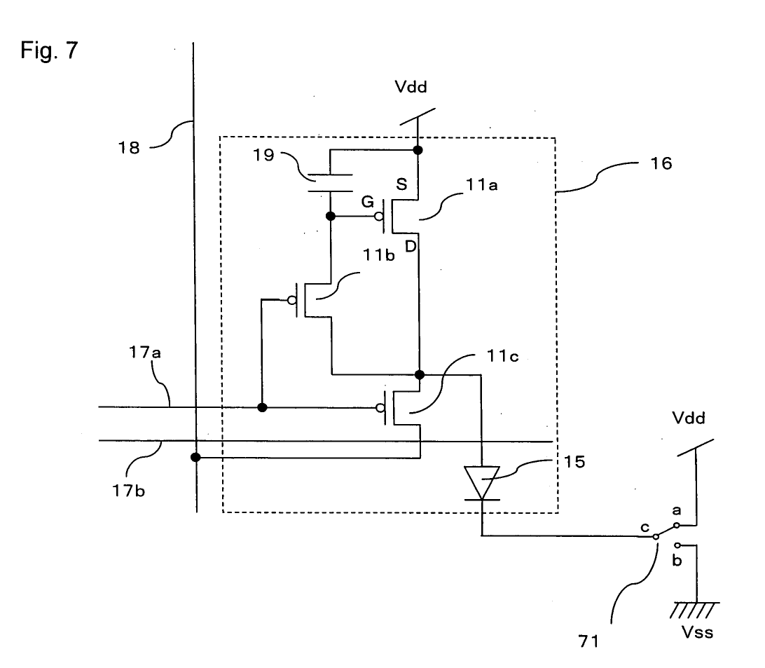

Incidentally, the pixel configuration according to the present invention is not limited to those shown in FIGS. 1 and 12. For example, pixels may be configured as shown in FIG. 7. FIG. 7 lacks the switching transistor 11d unlike the configuration in FIG. 1. Instead, a changeover switch 71 is formed or placed. The switch 11d in FIG. 1 functions to turn on and off (pass and shut off) the current delivered from the driver transistor 11a to the EL element 15. As also described in subsequent examples, the on/off control function of the transistor 11d constitutes an important part of the present invention. The configuration in FIG. 7 achieves the on/off function without using the transistor 11d.

In FIG. 7, a terminal a of the changeover switch 71 is connected to anode voltage Vdd. Incidentally, the voltage applied to the terminal a is not limited to the anode voltage Vdd. It may be any voltage that can turn off the current flowing through the EL element 15.

A terminal b of the changeover switch 71 is connected to cathode voltage (indicated as ground in FIG. 7). Incidentally, the voltage applied to the terminal b is not limited to the cathode voltage. It may be any voltage that can turn on the current flowing through the EL element 15.

A terminal c of the changeover switch 71 is connected with a cathode terminal of the EL element 15. Incidentally, the changeover switch 71 may be of any type as long as it has a capability to turn on and off the current flowing through the EL element 15. Thus, its installation location is not limited to the one shown in FIG. 7 and the switch may be located anywhere on the path through which current is delivered to the EL element 15. Also, the switch is not limited by its functionality as long as the switch can turn on and off the current flowing through the EL element 15. In short, the present invention can have any pixel configuration as long as switching means capable of turning on and off the current flowing through the EL element 15 is installed on the current path for the EL element 15.

Also, the term “off” here does not mean a state in which no current flows, but it means a state in which the current flowing through the EL element 15 is reduced to below normal. The items mentioned above also apply to other configurations of the present invention. That is, the transistor 11d may pass a leakage current which illuminates the EL element 15.

The changeover switch 71 will require no explanation because it can be implemented easily by a combination of P-channel and N-channel transistors. Of course, the switch 71 can be constructed of only P-channel or N-channel transistors because it only turns off the current flowing through the EL element 15.

When the switch 71 is connected to the terminal a, the anode voltage Vdd is applied to the cathode terminal of the EL element 15. Thus, current does not flow through the EL element 15 regardless of the voltage state of voltage held by the gate terminal G of the driver transistor 11a. Consequently, the EL element 15 is non-illuminated. Of course, the voltage at the terminal a of the changeover switch (circuit) 71 can be set such that the voltage between the source terminal (S) and drain terminal (D) of the driver transistor 11a can be at or near the cutoff point.

When the switch 71 is connected to the terminal b, the cathode voltage GND is applied to the cathode terminal of the EL element 15. Thus, current flows through the EL element 15 according to the state of voltage held by the gate terminal G of the driver transistor 11a. Consequently, the EL element 15 is illuminated.

Thus, in the pixel configuration shown in FIG. 7, no switching transistor 11d is formed between the driver transistor 11a and the EL element 15. However, it is possible to control the illumination of the EL element 15 by controlling the switch 71.

The switching transistor 11 and the like of the pixels 16 may be phototransistors. For example, by turning on and off the phototransistors 11 depending on the intensity of external light and thereby controlling the current flowing through the EL elements 15, it is possible to change the brightness of the display panel.

In the pixel configurations shown in FIGS. 1, 2, 6, 11 and 12, etc., one pixel contains one driver transistor 11a or 11b. However, the present invention is not limited to this and one pixel may contain two or more driver transistors 11a.

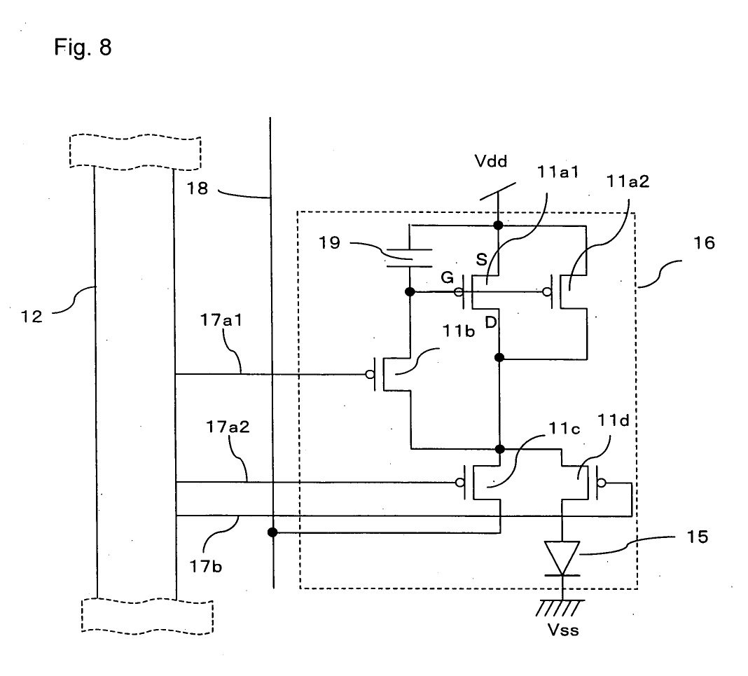

An example is shown in FIG. 8, where two or more driver transistors 11a are implemented or constructed in one pixel 16. In FIG. 8, one pixel contains two driver transistors 11a1 and 11a2, whose gate terminals are connected to a common capacitor 19. By using a plurality of driver transistors 11a, it is possible to reduce variations in programming current. The other part of the configuration is the same as those shown in FIG. 1 and the like, and thus description thereof will be omitted.

In FIG. 8, it goes without saying that three or more driver transistors 11a may be constructed (implemented). Further, a plurality of driver transistors 11a can be constructed (implemented) using both P-channel and N-channel.

In FIGS. 1 and 12, the current outputted by the driver transistor 11a is passed through the EL element 15 and turned on and off by the switching element 11d or the transistor lie formed between the driver transistor 11a and the EL element 15. However, the present invention is not limited to this. For example, another configuration is illustrated in FIG. 9.

In the example shown in FIG. 9, the current delivered to the EL element 15 is controlled by the driver transistor 11a. The current flowing through the EL element 15 is turned on and off by the switching element 11d placed between the Vdd terminal and EL element 15. Thus, according to the present invention, the switching element 11d may be placed anywhere as long as it can control the current flowing through the EL element 15. The other part of the operation is similar to or the same as those shown in FIG. 1 and the like, and thus description thereof will be omitted.

Also, in the pixel configuration in FIG. 10, all transistors are constructed of N-channel. However, the present invention does not limit the EL element configuration only of N-channel. It may be constructed of both N-channel and P-channel.

The pixel configuration in FIG. 10 is controlled using two timings. The first timing is the one when required current values are stored. In the first timing, the transistor 11b and transistor 11c are turned on because the turn-on voltage (Vgh) is applied to the gate signal lines 17a1 and 17a2. Also, turn-off voltage (Vgl) is applied to the gate signal line 17b and the transistor 11d is turned off. Then, a predetermined current Iw is applied from source signal lines 18. This makes the gate and drain of the transistor 11a short connected. The driver transistor 11a allows the program current to flow through transistor 11c.

To complete a current programming period (normally, one horizontal scanning period) in a selected pixel row, a turn-off voltage (Vgh) is applied to the gate signal line 17a1, turning off the transistor 11b. At this time, a turn-on voltage (Vgl) is applied to the gate signal line 17a2 and the transistor 11c remains on. Then, a turn-off voltage (Vgh) is applied to the gate signal line 17a2, turning off the transistor 11c.

Thus, when both transistors 11b and 11c are in on state, to turn off both transistors 11b and 11c (to finish a current programming period of the given pixel row), first the transistor 11b is turned off, breaking the connection between the gate terminal (G) and drain terminal (D) of the transistor 11a (a turn-off voltage (Vgh) is applied to the gate signal line 17a1). Next, the transistor 11c is turned off, disconnecting the drain terminal (D) of the transistor 11a from the source signal line 18 (a turn-off voltage (Vgh) is applied to the gate signal line 17a2 as well).

In the second timing, the turn-off voltage is applied to the gate signal lines 17a1 and 17a2 and the turn-on voltage is applied to the gate signal line 17b. Accordingly, the transistor 11b and transistor 11c are turned off and the transistor 11d is turned on. In this case, since the transistor 11a always operates in a saturation region, the current Iw remains constant.

In the pixel of current programming (in FIGS. 1, 6 to 13 and 31 to 36, etc.), variations in the characteristics of the driver transistor 11a (transistor 11b in FIGS. 11, 12, etc.) are correlated to the transistor size. To reduce the variations in the characteristics, preferably the channel length L of the driver transistor 11 is from 5 μm to 100 μm (both inclusive). More preferably, it is from 10 μm to 50 μm (both inclusive). This is probably because a long channel length L increases grain boundaries contained in the channel, reducing electric fields, and thereby suppressing kink effect.

Thus, according to the present invention, circuit means which controls the current flowing through the EL element 15 is constructed, formed, or placed on the path along which current flows into the EL element 15 and the path along which current flows out of the EL element 15 (i.e., the current path for the EL element 15).

Even in the case of current mirroring, a type of current programming, by forming or placing a transistor 11e as a switching element between the driver transistor 11b and EL element 15 as shown in FIGS. 11 and 12, it is possible to turn on and off the current flowing through the EL element 15. The transistor 11e may be substituted with the switch (circuit) 71 in FIG. 7.

Although the switching transistors lid and 11c in FIG. 11 are connected to a single gate signal line 17a, the switching transistor 11c may be controlled by a gate signal line 17a2 and the switching transistor 11d may be controlled by a gate signal line 17a1 as shown in FIG. 12. As explained, the pixel configuration in FIG. 12 makes pixel 16 control more versatile and makes the characteristic compensation performance of the driver transistor 11b improve.

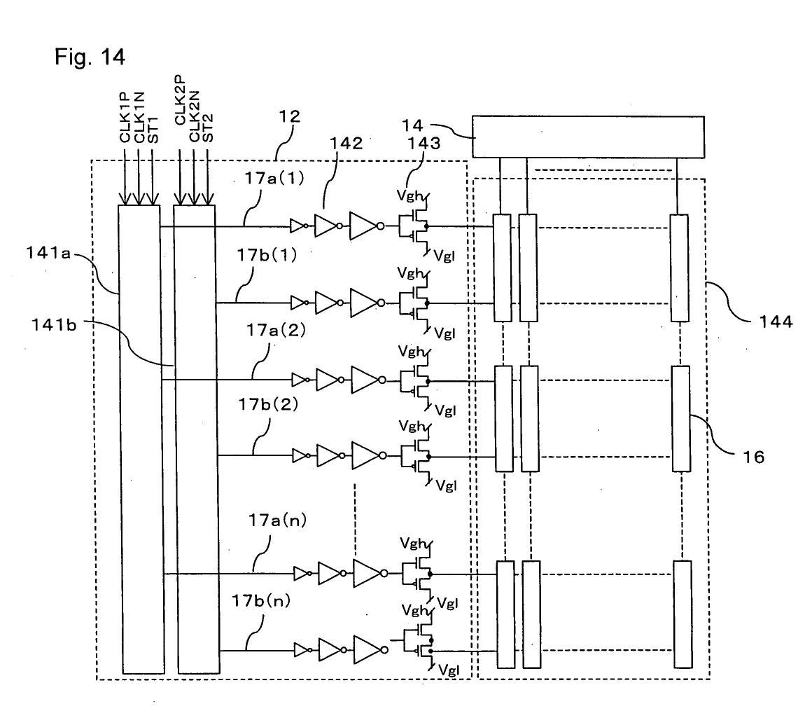

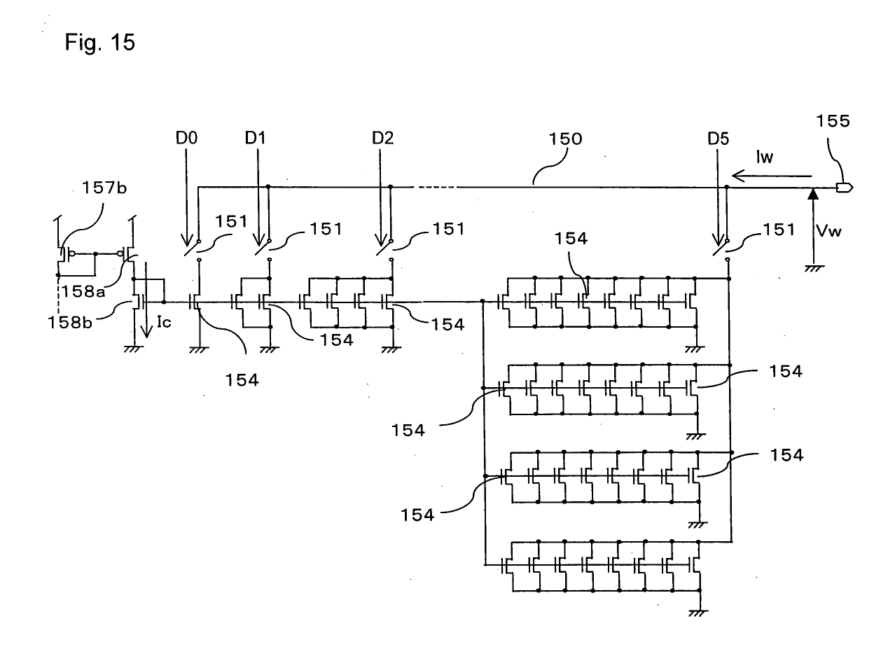

Next, the EL display panel or EL display apparatus of the present invention will be described. FIG. 14 is an explanatory diagram which mainly illustrates a circuit of the EL display apparatus. Pixels 16 are arranged or formed in a matrix. Each pixel 16 is connected with a source driver circuit (IC) 14 which outputs program current for use in current programming of the pixel. In an output stage of the source driver circuit (IC) 14 are current mirror circuits (described later) corresponding to the bit count of a video signal. For example, if 64 gradations are used, 63 current mirror circuits are formed on respective source signal lines so as to apply desired current to the source signal lines 18 when an appropriate number of current mirror circuits is selected (see FIGS. 15, 57, 58, 59 etc.).

The minimum output current of the unit transistor 154 of the source driver circuit (IC) 14 is from 0.5 nA to 100 nA (both inclusive). Preferably, the minimum output current of the unit transistor 154 should be from 2 nA to 20 nA (both inclusive) to secure accuracy of the the unit transistor 154 composing the unit transistor group 431c in the driver IC 14.

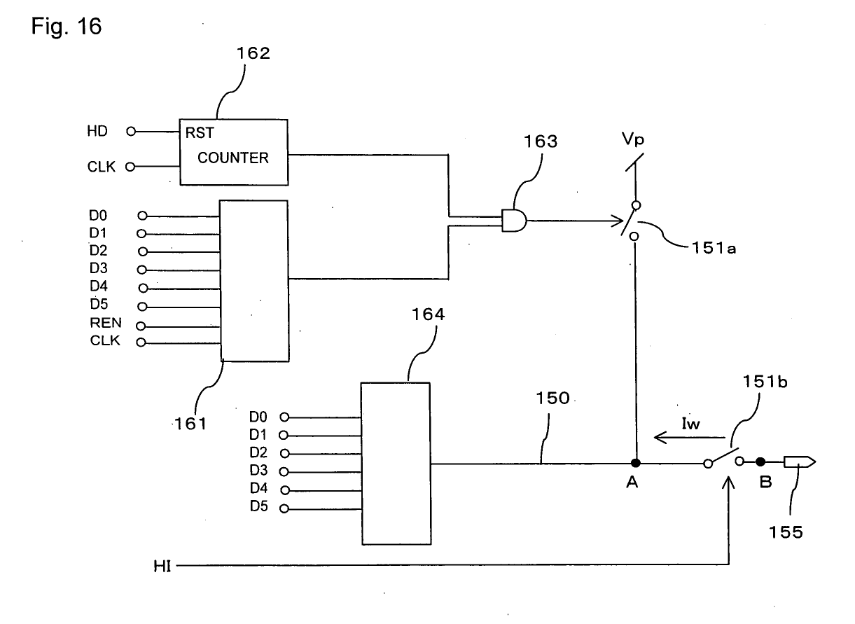

The source driver circuit (IC) 14 incorporates a precharge circuit to charge or discharge the source signal line 18 forcibly. See FIG. 16 etc. Preferably, voltage (current) output values of the precharge or discharge circuit which charges or discharges the source signal line 18 forcibly can be set separately for R, G, and B. This is because the thresholds of the EL element 15 differ among R, G, and B.

The precharge voltage can be regarded as a means of applying a voltage not higher than a rising voltage to the gate terminal (G) of the driver transistor 11a. That is, the driver transistor 11a is turned off to set the programming current Iw to 0 so that current will not flow through the EL element 15. The charging and discharging of the source signal line 18 are subsidiary.

According to the present invention, the source driver circuit (IC) 14 is made of a semiconductor silicon chip and connected with a terminal on the source signal line 18 of the board 30 by glass-on-chip (COG) technology. On the other hand, the gate driver circuit 12 is formed by low-temperature polysilicon technology. That is, it is formed in the same process as the transistors in pixels. This is because the gate driver circuit 12 has a simpler internal structure and lower operating frequency than the source driver circuit (IC) 14. Thus, it can be formed easily even by low-temperature polysilicon technology and allows bezel width of the display panel to be reduced. Of course, it is possible to construct the gate driver circuit 12 from a silicon chip and mount it on the board 30 using the COG technology. Also, it is possible to mount the gate driver circuit (IC) 12 and the source driver circuit (IC) 14 using the COF or the TAB technology. Also, switching elements such as pixel transistors as well as gate drivers may be formed by high-temperature polysilicon technology or may be formed of an organic material (organic transistors).

The gate driver circuit 12 incorporates a shift register circuit 141a for a gate signal line 17a and a shift register circuit 141b for a gate signal line 17b. For ease of explanation, the pixel configuration is described according to, for example, FIG. 1. If the gate signal line 17a is composed of the gate signal lines 17a1 and 17a2, a separate shift register circuit 141 is formed for each gate signal line or control signals for the gate signal lines 17a1 and 17a2 are generated by a logic circuit using output signals of the shift register circuits 141.

The shift register circuits 141 are controlled by positive-phase and negative-phase clock signals (CLK×P and CLK×N) and a start pulse (ST×) (see FIG. 14). Besides, it is preferable to add an enable (ENABL) signal which controls output and non-output from the gate signal line and an up-down (UPDWN) signal which turns a shift direction upside down. Also, it is preferable to install an output terminal to ensure that the start pulse is shifted by the shift register circuit 141 and is outputted.

Shift timings of the shift register circuits 141 are controlled by a control signal from a control IC 760 as later described. Also, the gate driver circuit 12 incorporates a level shift circuit 141 which level-shifts external data. By using only positive-phase clock signals, it is possible to reduce the number of signal lines and thereby reduce bezel width.

Since the shift register circuits 141 have small buffer capacity, they cannot drive the gate signal lines 17 directly. Therefore, at least two or more inverter circuits 142 are formed between each shift register circuit 141 and an output gate 143 which drives the gate signal line 17.

The same applies to cases in which the source driver circuit (IC) 14 is formed on the board 30 by polysilicon technology such as low-temperature polysilicon technology. A plurality of inverter circuits are formed between an analog switching gate such as a transfer gate which drives the source signal line 18 and the shift register of the source driver circuit (IC) 14.

The following matters (shift register output and output stages which drive signal lines (inverter circuits placed between output stages such as output gates or transfer gates) are common to the gate driver circuit and source driver circuit.

Regarding a color temperature of EL display panel, when white balance is adjusted in a color temperature range of 7000 K (Kelvin) to 12000 K (both inclusive), difference between current densities of different colors should be within ±30%. More preferably, the difference should be within ±15%. For example, if current densities are around 100 A/square meter, all the three primary colors should have a current density of 70 A/square meter to 130 A/square meter (both inclusive). More preferably, all the three primary colors should have a current density of 85 A/square meter to 115 A/square meter (both inclusive).

The organic EL element 15 is a self-luminous element. When light from this self-luminous element enters a transistor serving as a switching element, a photoconductive phenomenon occurs. The photoconductive phenomenon is a phenomenon in which leakage (off-leakage) increases due to photoexcitation when a switching element such as a transistor is off.

To deal with this problem, the present invention forms a shading film under the gate driver circuit 12 (source driver circuit (IC) 14 in some cases) and under the pixel transistor 11. In particular, it is preferably to shade the transistor 11b placed between a potential position (denoted by c) of the gate terminal and potential position (denoted by a) of the drain terminal of the transistor 11a.

This configuration is shown in FIGS. 314(a) and 314(b). When the display panel is displaying black, in particular, the potential at the potential position b of the anode terminal of the EL element 15 in FIGS. 314(a) and 314(b) is close to cathode potential. Thus, when a TFT 17b is on, the potential a is low. Thus, the potential between the source terminal and drain terminal (potentials c and a) increases, making the transistor 11b prone to leakage. To solve this problem, it is useful to form a light-shielding film 3141 such as the one illustrated in FIGS. 314(a) and 314(b).

The light-shielding film 3141 is a thin film of metal such as chromiumand is 50 to 150 nm thick (both inclusive) A thin film will provide a poor shading effect while a thick film will cause irregularities, making it difficult to pattern the transistor 11 in an upper layer.

In the case of the driver circuit 12 and the like, it is necessary to reduce penetration of light not only from the topside, but also from the underside. This is because the photoconductive phenomenon will cause malfunctions. If cathode electrodes are made of metal films, the present invention also forms a cathode electrode on the surface of the driver circuit 12 and the like and uses it as a shading film.

However, if a cathode electrode is formed on the driver circuit 12, electric fields from the cathode electrode may cause driver malfunctions or place the cathode electrode and driver circuit in electrical contact. To deal with this problem, the present invention forms at least one layer of organic EL film, and preferably two or more layers, on the driver circuit 12 simultaneously with the formation of organic EL film on the pixel electrode.

A drive method according to the present invention will be described below. As shown in FIG. 1, the gate signal line 17a conducts when the row remains selected (since the transistor 11 in FIG. 1 is a P-channel transistor, the gate signal line 17a conducts when it is in low state) and the gate signal line 17b applies to the turn-off voltage when the row remains non-selected.

Parasitic capacitance (not shown) is present in the source signal line 18. The parasitic capacitance is caused by the capacitance at the junction of the source signal line 18 and gate signal line 17, channel capacitance of the transistors 11b and 11c, etc.

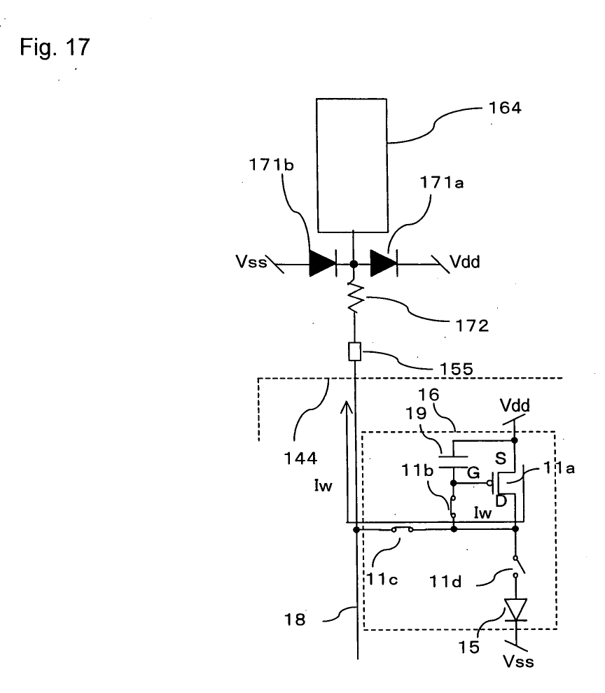

Parasitic capacitance is generated not only in the source signal line 18, but also in the source driver IC 14. As illustrated in FIG. 17, the protective diodes 171 are the main cause. The protective diodes 171 are intended to protect the IC 14 from static electricity, but they also acts as capacitors, causing parasitic capacitance. The capacitance of a typical protective diode is 3 to 5 pF.

In the source driver circuit (IC) 14 (described in detail later) according to the present invention, a surge limiting resistor 172 is formed or placed between the connection terminal 155 and current output circuit 164 as illustrated in FIG. 17. The resistor 172 is made of polysilicon or is a diffused resistor. The resistance of the resistor 172 should be between 1 KΩ and 1 MΩ (both inclusive). The resistor 172 controls external static electricity. This allows the size of the protective diodes 171 to be reduced. Reduction in the size of the protective diodes 171 results in reduction in the magnitude of the parasitic capacitance caused by the protective diodes.

Although FIG. 17 shows that the resistor 172 is formed or placed in the source driver IC 14, this is not restrictive. Needless to say, the resistor 172 may be formed or placed on the array 30. This also applies to the diodes (including transistors configured as diodes) 171.

Preferably, the resistors 171a and 171b are configured to allow their resistance to be adjusted by trimming. The resistance of the resistors 171a and 171b can be adjusted by trimming to eliminate leakage current flowing through the source signal line 18. It is also possible to adjust resistance and the like by a method other than trimming. If diffused resistors are used as the resistors 171, their resistance can be adjusted by heating. For example, the resistance can be adjusted by irradiating the resistors with a laser light and thereby heating them.

By heating the IC chip entirely or partially, it is possible to adjust or change the overall resistance in the IC chip or the resistance of some resistors. By forming a plurality of resistors 171a and the like and disconnecting one or more resistors 171a from the source signal line 18, it is possible to adjust the total resistance, eliminating leakage current and the like. Needless to say, the trimming and adjustment described above also apply to the resistor 172.

The time t required to change the current value of the source signal line 18 is given by t=C·V/I, where C is stray capacitance, V is a voltage of the source signal line, and I is a current flowing through the source signal line. For example, if the program current can be increased tenfold, the time required to change the current value can be reduced to 1/10. Thus, to apply a predetermined current value during a short horizontal scanning period, it is useful to increase the current value.

If the programming current is increased Nfold, the current flowing through the EL element 15 is also increased Nfold. Consequently, the brightness of the EL element 15 is increased Nfold as well. To obtain a predetermined brightness, for example, the conduction period of the transistor 17d in FIG. 1 is reduced to 1/N.

According to the above, in order to charge and discharge the parasitic capacitance of the source signal line 18 sufficiently and current program a predetermined current value into the transistor 11a of the pixel 16, it is necessary to output a relatively large current from the source driver circuit (IC) 14. However, when a N times larger program current is passed through the source signal line 18, its program current value is programmed into the pixel 16 and a current which is N times as much as the predetermined current flows through the EL element 15. For example, if a 10 times larger current is programmed, naturally a 10 times larger current flows through the EL element 15 and the EL element 15 emits 10 times brighter light. To obtain predetermined emission brightness, the time during which the current flows through the EL element 15 can be reduced tenfold. This way, the parasitic capacitance can be charged/discharged sufficiently from the source signal line 18 and the predetermined emission brightness can be obtained.

Incidentally, although it has been stated that a 10 times larger current value is written into the pixel transistor 11a (more precisely, the terminal voltage of the capacitor 19 is set) and that the conduction period of the EL element 15 is reduced to 1/10, this is only exemplary. In some cases, a 10 times larger current value may be written into the pixel transistor 11a and the conduction period of the EL element 15 may be reduced to ⅕. On the other hand, a 10 times larger current value may be written into the pixel transistor 11a and the conduction period of the EL element 15 may be halved. Also, a current value may be written into the pixel transistor 11a and the conduction period of the EL element 15 may be reduced to ⅕.

The present invention is characterized in that the write current into a pixel is set at a value other than a predetermined value and that a current is passed through the EL element 15 intermittently. For ease of explanation, it has been stated herein that an N times larger current is written into the driver transistor 11 of the pixel 16 and the conduction period of the EL element 15 is reduced to 1/N. However, this is not restrictive. Needless to say, N1 times (N1 is not limited to more than 1) larger current may be written into the driver transistor 11 of the pixel 16 and the conduction period of the EL element 15 may be reduced to 1/N2 (N2 is more than 1. N1 and N2 are different from each other).

According to the drive method of the present invention, for example, in white raster display, it is assumed that average brightness over one field (frame) period of the display screen 144 is B0. This drive method performs current programming in such a way that the brightness B1 of each pixel 16 is higher than the average brightness B0. Also, a non-display area 192 appears during at least one field (frame) period. Thus, in the drive method according to the present invention, the average brightness over one field (frame) period is lower than B1.

This method programs the pixels 16 with current at normal brightness during one field (frame) period so than a non-display area 192 will appear. With this method, average brightness during one field (frame) period is lower than with a normal drive method (conventional drive method). However, this method has the advantage of improving movie display performance.

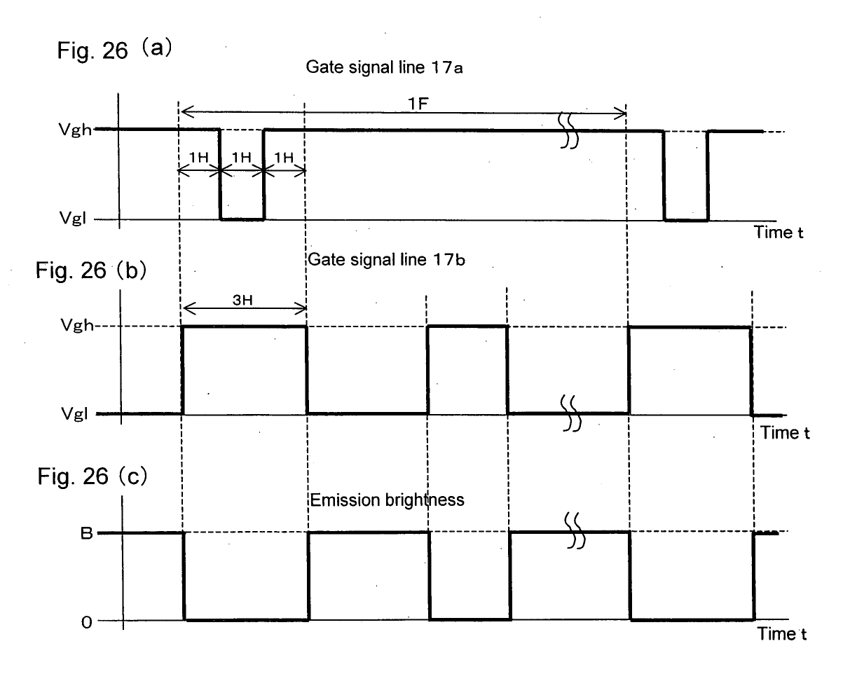

The pixel configuration according to the present invention is not limited to current-programming mode. For example, the present invention can use the pixel configuration in voltage-programming mode shown in FIG. 26. This is because it is useful in improving movie display performance even in voltage-programming mode to use high brightness display mode in a predetermined part of one field (frame) period and non-illumination mode in the rest of the period. Besides, the effect of parasitic capacitance of the source signal lines 18 cannot be ignored even in voltage-programming mode. The drive method according to the present invention is useful especially for large EL display panels, which are prone to large parasitic capacitance.

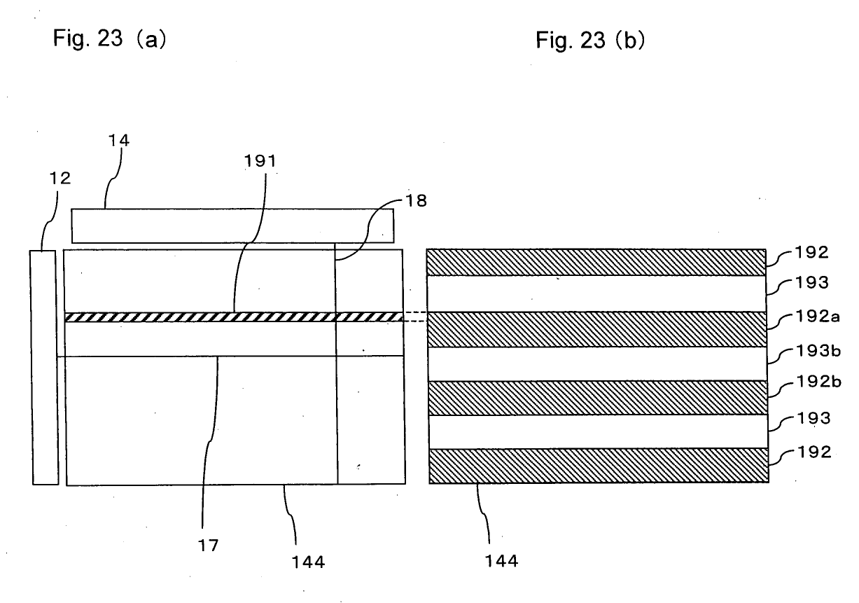

As shown in FIG. 23, the non-display area 192 and display area 193 are not necessarily spaced equally. For example, they may appear at random (provided that the display period or non-display period makes up a predetermined value (constant ratio) as a whole). Also, display periods may vary among R, G, and B. That is, display periods of R, G, and B or non-display period can be adjusted to a predetermined value (constant ratio) in such a way as to obtain an optimum white balance.

The non-display area 192 is a pixel 16 area in which EL elements 15 are non-illuminated at the given time. The display area 193 is a pixel 16 area in which EL elements 15 are illuminated at the given time. Both non-display area 192 and display area 193 are shifted by one pixel row at a time in sync with a horizontal synchronization signal.

To facilitate explanation of the drive method according to the present invention, it is assumed that “1/N” means reducing 1F (one field or one frame) to 1/N. Needless to say, however, it takes time to select one pixel row and to program current values (normally, one horizontal scanning period (1 H)) and error may result depending on scanning conditions. Of course, there can also be deviations from an ideal state due to penetration voltage of the gate signal lines 17. However, it is assumed here for ease of explanation that there is no deviation.

The liquid display panel holds the current (voltage) written into a pixel for 1F (one field or one frame) period. Thus, a problem is that displaying moving pictures will result in blurred edges.

Organic (inorganic) EL display panels (display apparatus) hold the current (voltage) written into a pixel for 1F (one field or one frame) period. Thus, they have the same problem as liquid crystal display panels. On the other hand, displays such as CRTs which display an image as a set of lines using an electron gun do not suffer edge blur of moving images because they use persistence of vision for image display.

According to the drive method of the present invention, current is passed through the EL element 15 only for a period of 1F/N, but current is not passed during the remaining period (1F(N−1)/N). Let us consider a situation in which the drive system of the present invention is implemented and one point on the screen is observed. In this display condition, image data display and black display (non-illumination) are repeated every 1F. That is, image data is displayed intermittently in the temporal sense. When moving picture data are displayed intermittently, a good display condition is achieved without edge blur. In short, movie display close to that of a CRT can be achieved.

The drive method according to the present invention implements intermittent display. However, in achieving the intermittent display, the transistor 11d simply turns on and off on a 1-H cycle at the maximum. Consequently, a main clock of the circuit does not differ from conventional ones, and thus there is no increase in the power consumption of the circuit. Liquid crystal display panels need an image memory in order to achieve intermittent display. According to the present invention, image data is held in each pixel 16. Thus, the drive method in the present invention requires no image memory for intermittent display.

The drive method of the present invention controls the current passed through the EL element 15 by simply turning on and off the switching transistor 11d, the transistor lie (FIG. 12, etc.), and the like. That is, even if the current Iw flowing through the EL element 15 is turned off, the image data is held as it is in the capacitor 19 of the pixel 16. Thus, when the switching element 11d is turned on the next time, the current passed through the EL element 15 has the same value as the current flowing through the EL element 15 the previous time.

Even to achieve black insertion (intermittent display such as black display), the present invention does not need to speed up the main clock of the circuit. Also, it does not need to elongate a time axis, and thus requires no image memory. Besides, the EL element 15 responds quickly, requiring a short time from application of current to light emission. Thus, the present invention is suitable for movie display, and by using intermittent display, it can solve a problem with conventional data-holding display panels (liquid crystal display panels, EL display panels, etc.) in displaying moving pictures.

Furthermore, in a large display apparatus, if increased wiring length of the source signal line 18 results in increased parasitic capacitance in the source signal line 18, this can be dealt with by increasing the value of N. When the value of programming current applied to the source signal line 18 is increased N times, the conduction period of the gate signal line 17b (the transistor 11d) can be set to 1F/N. This makes it possible to apply the present invention to television sets, monitors, and other large display apparatus.

In the case of current driving, especially image display at the black level, the pixel capacitor 19 needs to be programmed with a minute current of 20 nA or less. Thus, if parasitic capacitance larger than a predetermined value is generated, the parasitic capacitance cannot be charged and discharged during the time when one pixel row is programmed (basically within 1 H, but not limited to 1 H because two pixel rows may be programmed simultaneously). If the parasitic capacitance cannot be charged and discharged within a period of 1 H, sufficient current cannot be written into the pixel, resulting in inadequate resolution.

In the pixel configuration in FIG. 1, the programming current Iw flows through the source signal line 18 during current programming as shown in FIG. 6(a). The current Iw flows through the transistor 11a and voltage is set (programmed) in the capacitor 19 in such a way as to maintain the current Iw. At this time, the transistor 11d is open (off).

During a period when the current flows through the EL element 15, the transistors 11c and 11b turn off and the transistor 11d turns on as shown in FIG. 6(b). Specifically, a turn-off voltage (Vgh) is applied to the gate signal line 17a, turning off the transistors 11b and 11c. On the other hand, a turn-on voltage (Vgl) is applied to the gate signal line 17b, turning on the transistor 11d.

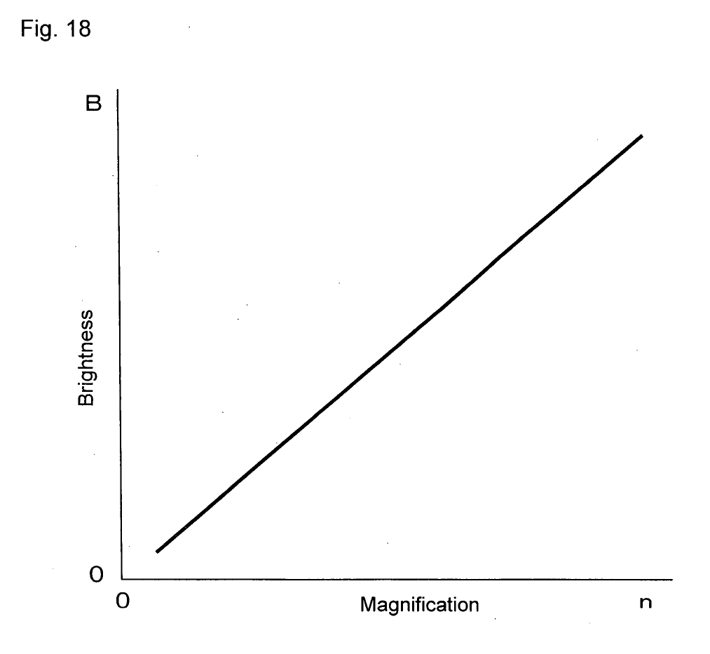

Suppose a program current Iw is N times the current which should normally flow (a predetermined value), the current flowing through the EL element 15 in FIG. 6(b) is also Ie. Thus, the EL element 15 emits light 10 times more brightly that a predetermined value. In other words, as shown in FIG. 18, the larger the magnification N, the higher the instant display brightness B of the pixel 16. The magnification N and the brightness of the pixel 16 are basically proportional to each other.

If the transistor 11d is kept on for a period 1/N the period during which it is normally kept on (approximately 1F) and is kept off during the remaining period (N−1)/N, the average brightness over the 1F equals predetermined brightness. This display condition closely resembles the display condition under which a CRT is scanning a screen with an electronic gun. The difference is that 1/N of the entire screen illuminates (where the entire screen is taken as 1) in the range where the image is displayed (in a CRT, what illuminates is one pixel row—more precisely, one pixel).

According to the present invention, 1F/N of the display (illumination) area 193 moves from top to bottom of the screen 144 as shown in FIG. 19(b). The scanning direction of the display area 193 may be from bottom of the screen 144 to the top, or may be at random.

According to the present invention, current flows through the EL element 15 only for the period of 1F/N, but current does not flow to the EL element 15 of the applied pixel row during the remaining period (1F·(N−1)/N). Thus, the pixel is displayed intermittently. However, due to an afterimage, the entire screen appears to be displayed uniformly to the human eye.

As shown in FIG. 19, the write pixel row 191a is non-illuminated area 192. However, this is true only to the pixel configurations in FIGS. 1, 2, etc. In the pixel configuration of a current mirror shown in FIGS. 11, 12, etc., the write pixel row 191 may be illuminated. However, description will be given herein citing mainly the pixel configuration in FIG. 1 for ease of explanation.

As described above, a drive method which involves driving a pixel intermittently by programming it with a current larger than the predetermined drive current Iw shown in FIGS. 19, 23, etc. is referred to as N-fold pulse driving. In the drive method in FIG. 19, image data display and black display (non-illumination) are repeated every 1F. That is, image data is displayed at intervals (intermittently) in the temporal sense.

Liquid crystal display panels (EL display panels other than that of the present invention), which hold data in pixels for a period of 1F, cannot keep up with changes in image data during movie display, resulting is blurred moving pictures (edge blur of images). Since the present invention displays images intermittently, it can achieve a good display condition without edge blur of images. In short, movie display close to that of a CRT can be achieved.

To drive the pixel 16 as shown in FIG. 19, it is necessary to be able to separately control the current programming period of the pixel 16 (in the configuration shown in FIG. 1, the period during which the turn-on voltage Vgl is applied to the gate signal line 17a) and the period when the EL element 15 is under on/off control (in the pixel configuration shown in FIG. 1, the period during which the turn-on voltage Vgl or turn-off voltage Vgh is applied to the gate signal line 17b). Thus, the gate signal line 17a and gate signal line 17b must be separated.

For example, when only a single gate signal line 17 is laid from the gate driver circuit 12 to the pixel 16, the drive method according to the present invention cannot be implemented using a configuration in which logic (Vgh or Vgl) applied to the gate signal line 17 is applied to the transistor 11b and the logic applied to the gate signal line 17 is converted (Vgh or Vgl) by an inverter and applied to the transistor 11d. Thus, the present invention requires a gate driver circuit 12a which operates the gate signal line 17a and gate driver circuit 12b which operates the gate signal line 17b.

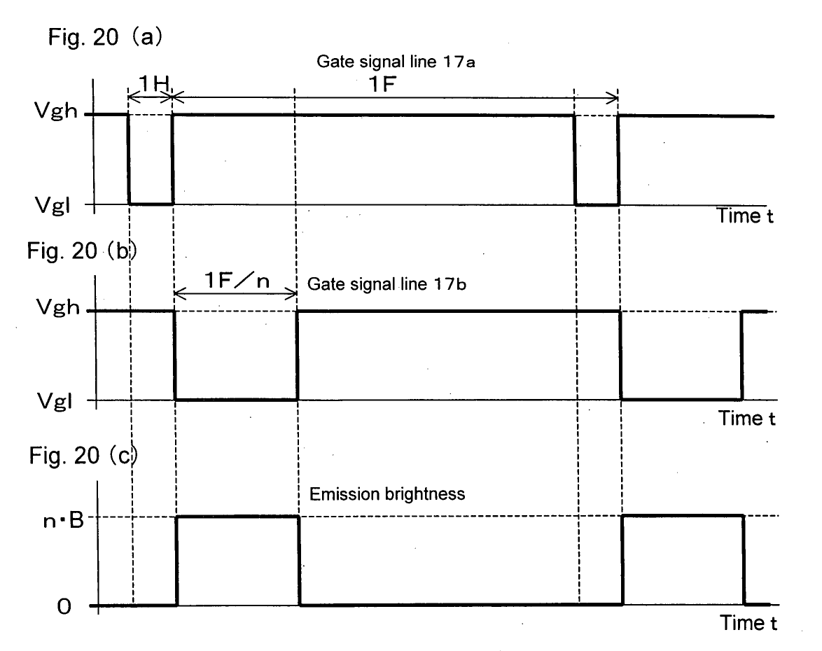

A timing chart of the drive method shown in FIG. 19 is illustrated in FIG. 20. For ease of explanation, the pixel configuration referred to in the present invention and the like is the one shown in FIG. 1 unless otherwise stated. As can be seen from FIG. 20, in each selected pixel row (the selection period is designated as 1 H), when a turn-on voltage (Vgl) is applied to the gate signal line 17a (see FIG. 20(a)), a turn-off voltage (Vgh) is applied to the gate signal line 17b (see FIG. 20(b)). During this period, current does not flow through the EL element 15 (non-illumination mode).

In a non-selected pixel row, a turn-on voltage (Vgl) is applied to the gate signal line 17b and a turn-off voltage (Vgh) is applied to the gate signal line 17a. During this period, current flows through the EL element 15 (illumination mode). In the illumination mode, the EL element 15 illuminates at a brightness (N·B) N times the predetermined brightness and the illumination period is 1F/N. Thus, the average display brightness of the display panel over 1F is given by (N·B)×(1/N)=B (the predetermined brightness). The value of N can be more than one.

FIG. 21 shows an example in which operations shown in FIG. 20 are applied to each pixel row. The figure shows voltage waveforms applied to the gate signal lines 17. Waveforms of the turn-off voltage are denoted by Vgh (high level) while waveforms of the turn-on voltage are denoted by Vgl (low level). The subscripts such as (1) and (2) indicate selected pixel row numbers.

In FIG. 21, a gate signal line 17a(1) is selected (Vgl voltage) and a programming current flows through the source signal line 18 in the direction from the transistor 11a in the selected pixel row to the source driver circuit (IC) 14. The programming current is N times larger than a predetermined value. Since the predetermined value is a data current for use to display images, it is not a fixed value unless in the case of white raster display). The capacitor 19 is programmed so that a N times larger current will flow through the transistor 11a. When the pixel row (1) is selected, in the pixel configuration shown in FIG. 1, a turn-off voltage (Vgh) is applied to the gate signal line 17b(1) and current does not flow through the EL element 15.

After 1 H, a gate signal line 17a(2) is selected (Vgl voltage) and a programming current flows through the source signal line 18 in the direction from the transistor 11a in the selected pixel row to the source driver circuit (IC) 14. The programming current is N times larger than a predetermined value. The capacitor 19 is programmed so that N times larger current will flow through the transistor 11a. When the pixel row (2) is selected, in the pixel configuration shown in FIG. 1, a turn-off voltage (Vgh) is applied to the gate signal line 17b(2) and current does not flow through the EL element 15. However, since a turn-off voltage (Vgh) is applied to the gate signal line 17a(1) and a turn-on voltage (Vgl) is applied to the gate signal line 17b(1) of the pixel row (1), the EL element 15 illuminates.

After the next 1 H, a gate signal line 17a(3) is selected, a turn-off voltage (Vgh) is applied to the gate signal line 17b(3), and current does not flow through the EL element 15 in the pixel row (3). However, since a turn-off voltage (Vgh) is applied to the gate signal lines 17a(1) and (2) and a turn-on voltage (Vgl) is applied to the gate signal lines 17b(1) and (2) in the pixel rows (1) and (2), the EL element 15 illuminates.

Through the above operation, images are displayed in sync with a synchronization signal of 1 H. However, with the drive method in FIG. 21, N times larger current flows through the EL element 15. Thus, the display screen 144 is N times brighter. Of course, it goes without saying that for display at a predetermined brightness in this state, the programming current can be reduced to 1/N.

However, 1/N times smaller current will cause a shortage of write current due to parasitic capacitance. Thus, the basic idea of the present invention is to use a large current for programming, insert a black screen (non-illuminated display area) 192, and thereby obtain a predetermined brightness.

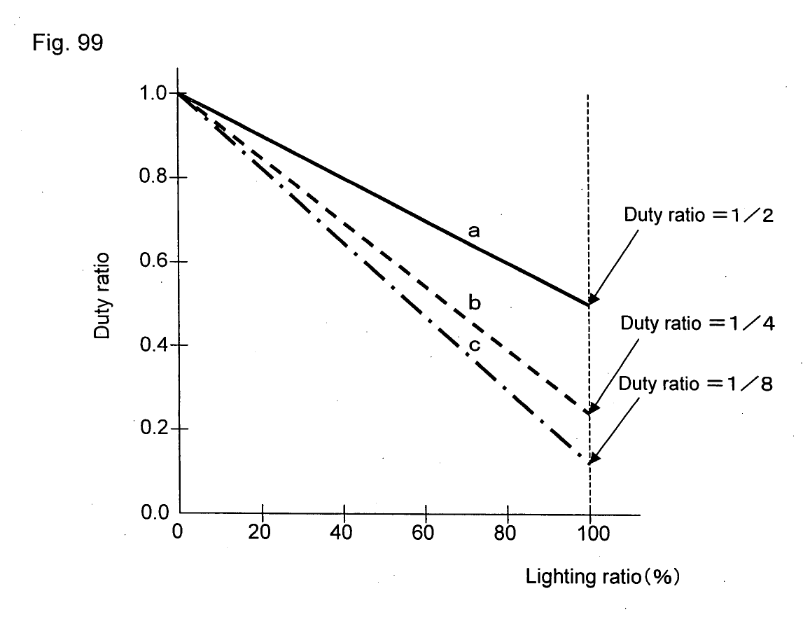

Needless to say, however, if the effect of parasitic capacitance is negligible or insignificant, the drive method according to the present invention can be used assuming that N=1. This drive method will be described later with reference to FIGS. 99 to 116, etc.

Incidentally, the drive method according to the present invention causes a current larger than a predetermined current to flow through the EL element 15, and thereby charges and discharges the parasitic capacitance of the source signal line 18 sufficiently. That is, there is no need to pass an N times larger current through the EL element 15. For example, it is conceivable to form a current path in parallel with the EL element 15 (form a dummy EL element and use a shield film to prevent the dummy EL element from emitting light) and divide the flow of program current between the EL element 15 and the dummy EL element. For example, program current which writes to the pixel 16 for programming is 0.2 μA. Program current which outputs from the source driver circuit (IC) 14 is 2.0 μA.

Thus, for the source driver circuit (IC) 14, N=2.0/0.2=10. Of the programming current outputted from the source driver circuit (IC) 14, 1.8 μA (2.0−0.2) is passed through the dummy pixels. The remaining 0.2 μA is passed through the driver transistors 11a of the pixels 16 to be programmed. The dummy pixel row is either kept from emitting light or hidden from view by a shield film or the like even if it emits light.

With the above configuration, by increasing the current passed through the source signal line 18 N times, it is possible to pass an N times larger current through the driver transistor 11a and pass a current sufficiently smaller than the N times larger current through the EL element 15.

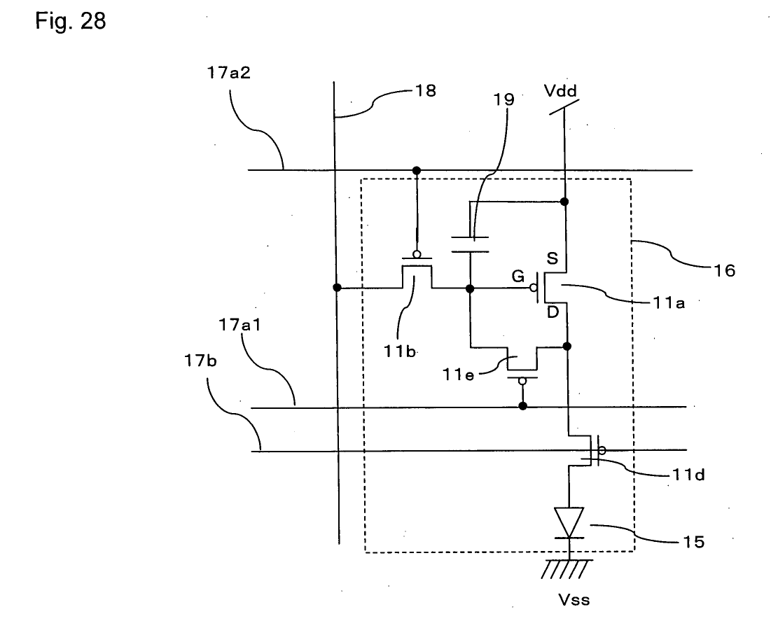

FIG. 19(a) shows writing into the display screen 144. In FIG. 19(a), reference numeral 191a denotes a write pixel row. A programming current is supplied to the source signal line 18 from the source driver IC 14. In FIG. 19 and the like, there is one pixel row into which current is written during a period of 1 H, but this is not restrictive. The period may be 0.5 H or 2 Hs. Also, although it has been stated that a programming current is written into the source signal line 18, the present invention is not limited to current programming. The present invention may also use voltage programming (FIG. 28, etc.) which writes voltage into the source signal line 18.

In FIG. 19(a), when the gate signal line 17a is selected, the current to be passed through the source signal line 18 is programmed into the transistor 11a. At this time, a turn-off voltage is applied to the gate signal line 17b, and current does not flow through the EL element 15. This is because when the transistor 11d is on on the EL element 15, a capacitance component of the EL element 15 is visible from the source signal line 18 and the capacitance prevents sufficient current from being programmed into the capacitor 19. Thus, to take the configuration shown in FIG. 1 as an example, the pixel row into which current is written is a non-illuminated area 192 as shown in FIG. 19(b).

Suppose an N times larger current is used for programming (it is assumed that N=10 as described above), the screen becomes 10 times brighter. Thus, 90% of the display screen 144 can be constituted of the non-illuminated area 192. For example, if the number of horizontal scanning lines in the display screen of the display panel 144 is 220 (S=220) in compliance with QCIF, 22 horizontal scanning lines can compose a display area 193 while 220−22=198 horizontal scanning lines can compose a non-display area 192.

Generally speaking, if the number of horizontal scanning lines (number of pixel rows) is denoted by S, S/N of the entire area constitutes a display area 193, which is illuminated N times more brightly (N is more than 1). Then, the display area 193 is scanned in the vertical direction of the screen. Thus, S(N−1)/N of the entire area is a non-illuminated area 192. The non-illuminated area presents a black display (is non-luminous). Also, the non-luminous area 192 is produced by turning off the transistor 11d. Incidentally, although it has been stated that the display area 53 is illuminated N times more brightly, naturally the value of N changes by brightness adjustment and gamma adjustment.

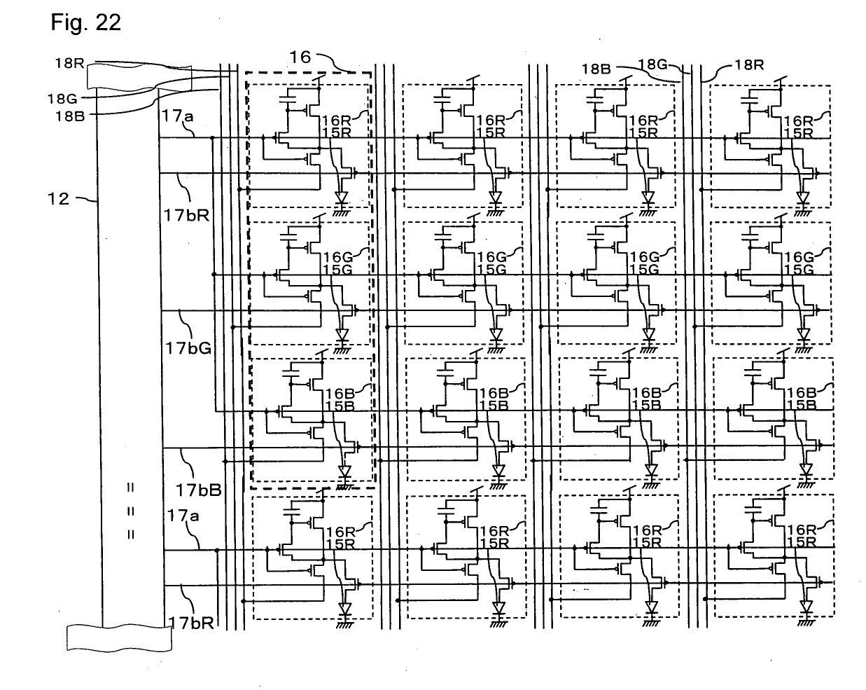

In the above example, if a 10 times larger current is used for programming, the screen becomes 10 times brighter and 90% of the display screen 144 can be constituted of the non-illuminated area 192. However, this does not necessarily mean that R, G, and B pixels constitute the non-illuminated area 192 in the same proportion. For example, ⅛ of the R pixels, ⅙ of the G pixels, and 1/10 of the B pixels may constitute the non-illuminated area 192 with different colors making up different proportions. It is also possible to allow the non-illuminated area 192 (or illuminated area 193) to be adjusted separately among R, G, and B. For that, it is necessary to provide separate gate signal lines 17b for R, G, and B. However, allowing R, G,.and B to be adjusted separately makes it possible to adjust white balance, making it easy to adjust color balance for each gradation. The example is shown in FIG. 22.

As shown in FIG. 19(b), pixel rows including the write pixel row 191a compose a non-illuminated area 192 while an area of S/N (1F/N in the temporal sense) above the write pixel row 191a compose a display area 193 (when write scans are performed from top to bottom of the screen. When the screen is scanned from bottom to top, the areas change places). Regarding the display condition of the screen, a strip of the display area 193 moves from top to bottom of the screen.

In FIG. 19, one display area 193 moves from top to bottom of the screen. At a low frame rate, the movement of the display area 193 is recognized visually. It tends to be recognized easily especially when a user closes his/her eyes or moves his/her head up and down.

To deal with this problem, the display area 193 can be divided into a plurality of parts as shown in FIG. 23. If the total area of the divided display area is S(N−1)/N, the brightness is equal to the brightness in FIG. 19. Incidentally, there is no need to divide the display area 193 equally. Also, there is no need to divide the non-display area 192 equally.

Dividing the display area 193 reduces flickering of the screen. Thus, a flicker-free good image display can be achieved. Incidentally, the display area 53 may be divided more finely. However, the more finely the display area 53 is divided, the poorer the movie display performance becomes.

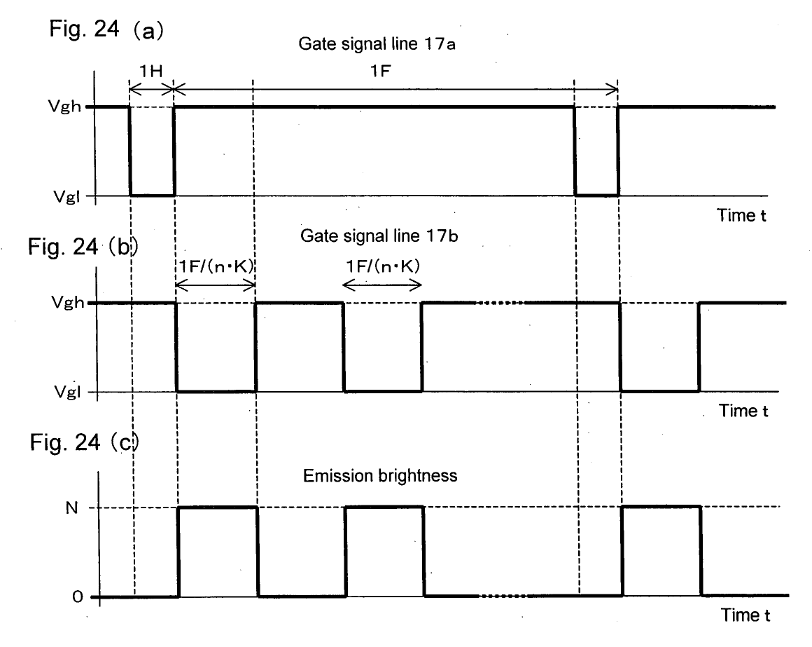

FIG. 24 shows voltage waveforms of gate signal lines 17 and emission brightness of the EL element. As can be seen from FIG. 24, a period (1F/N) during which the gate signal line 17b is set to Vg1 is divided into a plurality of parts (K parts). That is, a period of 1F/(K·N) during which the gate signal line 17b is set to Vg1 repeats K times. This reduces flickering and implements image display at a low frame rate.

Preferably, the number of divisions is variable. For example, when the user presses a brightness adjustment switch or turns a brightness adjustment knob, the value of K may be changed in response. Also, the user may be allowed to adjust brightness. Alternatively, the value of K may be changed manually or automatically depending on images or data to be displayed.

Although it has been stated with reference to FIG. 24 and the like that a period (1F/N) during which the gate signal line 17b is set to Vg1 is divided into a plurality of parts (K parts) and that a period of 1F/(K·N) during which the gate signal line 17b is set to Vg1 repeats K times, this is not restrictive. A period of 1F/(K·N) may be repeated L (L≠K) times. In other words, the present invention displays the display screen 144 by controlling the period (time) during which current is passed through the EL element 15. Thus, the idea of repeating the 1F/(K·N) period L (L≠K) times is included in the technical idea of the present invention. Also, by varying the value of L, the brightness of the display screen 144 can be changed digitally. For example, there is a 50% change of brightness (contrast) between L=2 and L=3. Also, when dividing the image display area 193, the period when the gate signal line 17b is set to Vg1 does not necessarily need to be divided equally.

In the example described above, the display screen 144 is turned on and off (illuminated and non-illuminated) as the current delivered to the EL element 15 is switched on and off and the path delivered to the EL element 15 is formed by the transistor 11d or the switch (circuit) 71, etc. That is, approximately equal current is passed through the drive transistor 11a multiple times using electric charges held in the capacitor 19. The present invention is not limited to this. For example, the display screen 144 may be turned on and off (illuminated and non-illuminated) by charging and discharging the capacitor 19.

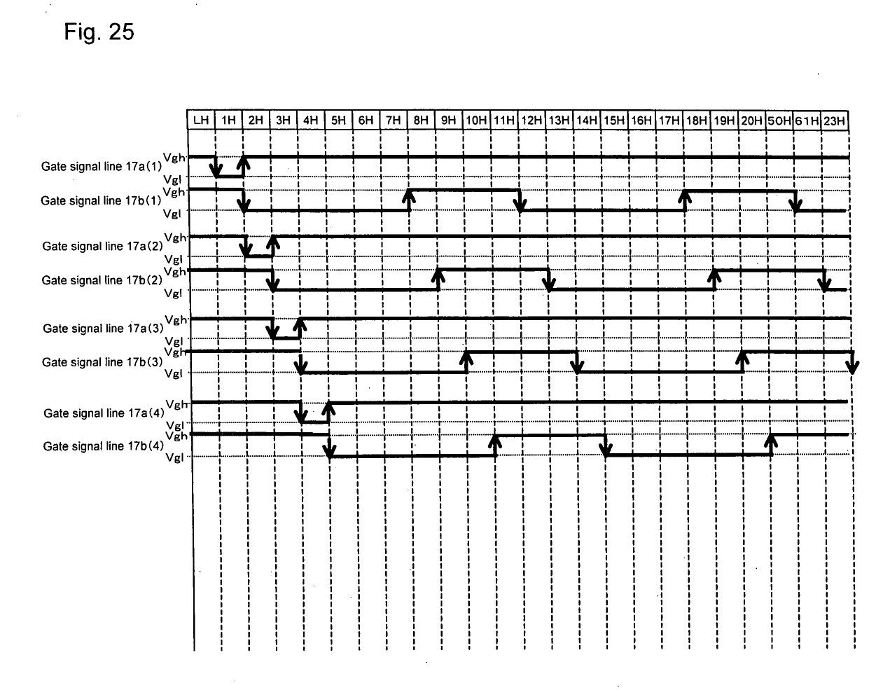

FIG. 25 shows voltage waveforms applied to gate signal lines 17 to achieve the image display condition shown in FIG. 23. FIG. 25 differs from FIG. 21 in the operation of the gate signal line 17b. The gate signal line 17b is turned on and off (Vgl and Vgh) as many times as there are screen divisions. FIG. 25 is the same as FIG. 21 in other respects, and thus description thereof will be omitted.

The ratio between the illuminated area 193 and the entire screen area 144 may be referred to herein as a duty ratio. That is, the duty ratio is “the area of the illuminated area 193” divided by “the area of the entire display screen 144.” To put it another way, the duty ratio is “the number of gate signal lines 17b to which a turn-on voltage is applied” divided by “the total number of gate signal lines 17b,” or “the number of selected pixel rows connected to the gate signal lines 17b to which a turn-on voltage is applied” divided by the total number of pixel rows in the entire screen area 144.

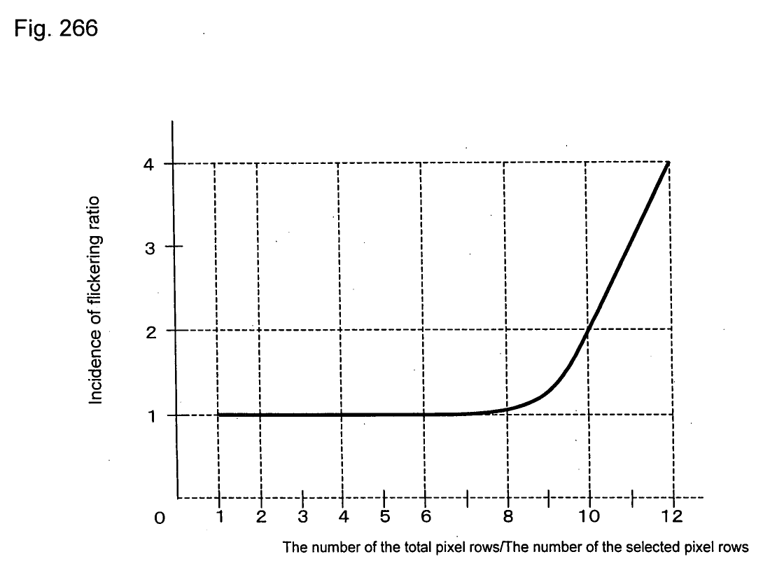

Flickering occurs if the inverse of the duty ratio (the total number of pixel rows/the number of selected pixel rows) is higher than a certain value. This relationship is shown in FIG. 266, where the horizontal axis represents “the total number of pixel rows“/”the number of selected pixel rows,” i.e., the inverse of the duty ratio. The vertical axis represents the incidence of flickering. Its smallest value is 1. With increases in this value, flickering becomes more conspicuous.

According to the results shown in FIG. 266, it is appropriate that “the total number of pixel rows“/”the number of selected pixel rows” should be 8 or less. That is, it is preferable that the duty ratio is 1/8 or higher. If some flickering is permissible (presents no practical harm), it is appropriate that “the total number of pixel rows“/”the number of selected pixel rows” should be 10 or less. That is, it is preferable that the duty ratio is 1/10 or higher.

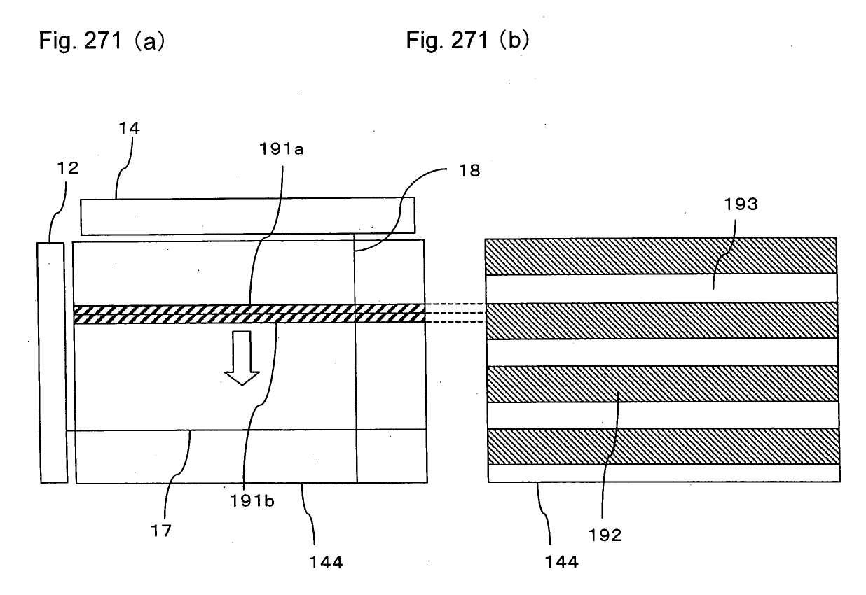

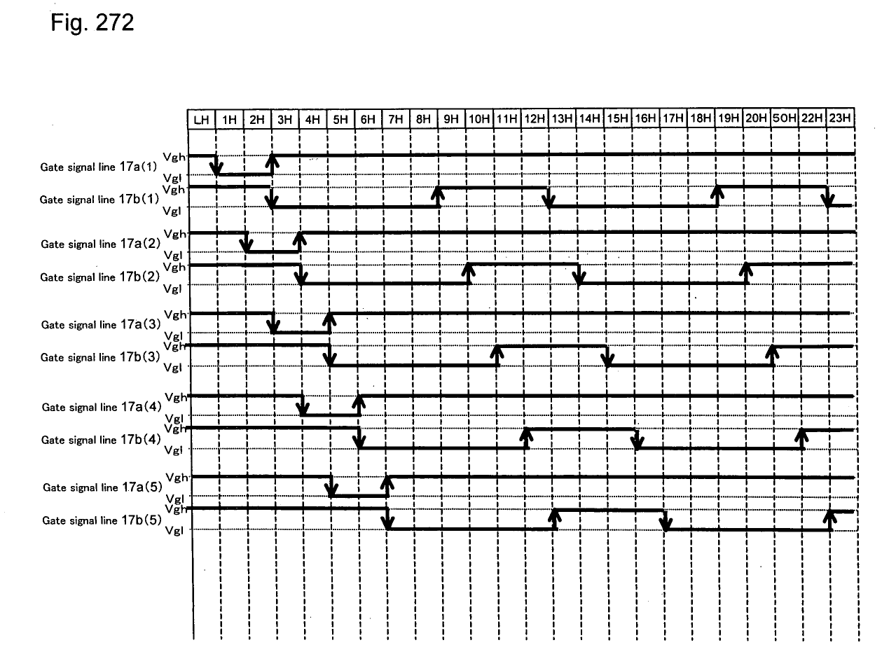

FIGS. 271 and 272 show an example of a drive method which selects two pixel rows simultaneously. When the pixel row (1) is a write pixel row in FIG. 271, gate signal lines 17a(1) and 17a(2) are selected (see FIG. 272). That is, the switching transistors 11b and transistors 11c of the pixel rows (1) and (2) are on. Further, when a turn-on voltage is applied to the gate signal line 17a of each pixel row, a turn-off voltage is applied to the gate signal line 17b.

Thus, in the first and second H periods, the switching transistors 11d in the pixel rows (1) and (2) are off and current does not flow through the EL elements 15 in the corresponding pixel rows. That is, the EL elements 15 are in non-illumination mode 192. Incidentally, in FIG. 271, the display area 193 is divided into five parts to reduce flickering.

Ideally, transistors 11a of two pixel rows pass a current of Iw×5 each through the source signal line 18 (when N=10, i.e., when K=2, the current flowing through the source signal line 18 is Iw×K×5=Iw×10). Thus, a current five times larger than Iw is programmed into the capacitor 19 of each pixel 16 and held.

Since two pixel rows are selected simultaneously (K=2), two driver transistors 11a operate. That is, 10/2=5 times larger current flows through the transistor 11a per pixel. The total programming current of the two transistors 11a flows through the source signal line 18.

For example, if a current conventionally written into the write pixel row 191a is Id, a current of Iw×10 is passed through the source signal line 18. There is no problem because regular image data is written into the write pixel rows 191b later. The pixel row 191b provides the same display as the pixel row 191a during a period of 1 H. Consequently, at least the write pixel row 191a and the pixel rows 191b selected to increase current are in non-display mode 192.

After the next 1 H, the gate signal line 17a(1) becomes des elected and a turn-on voltage (Vgl) is applied to the gate signal line 17b. At the same time, the gate signal line 17a(3) is selected (Vgl voltage) and a programming current flows through the source signal line 18 in the direction from the transistor 11a in the selected pixel row (3) to the source driver 14. Through this operation, regular image data is held in the pixel row (1).

After the next 1 H, the gate signal line 17a(2) becomes des elected and a turn-on voltage (Vgl) is applied to the gate signal line 17b. At the same time, the gate signal line 17a(4) is selected (Vgl voltage) and a programming current flows through the source signal line 18 in the direction from the transistor 11a in the selected pixel row (4) to the source driver 14. Through this operation, regular image data is held in the pixel row (2). The entire screen is redrawn as it is scanned by shifting pixel rows one by one through the above operations (of course, two or more pixel rows may be shifted simultaneously. For example, in the case of pseudo-interlaced driving, two pixel rows will be shifted at a time. Also, from the viewpoint of image display, the same image may be written into two or more pixel rows).

With the drive method in FIG. 271, since each pixel is programmed with a five times larger current, ideally the emission brightness of the EL element 15 of each pixel is five times higher. Thus, the brightness of the display area 193 is five times higher than a predetermined value. To equalize this brightness with the predetermined brightness, an area which includes the write pixel rows 191 and which is one fifth as large as the display screen 1 can be turned into a non-display area 192 as above-described.

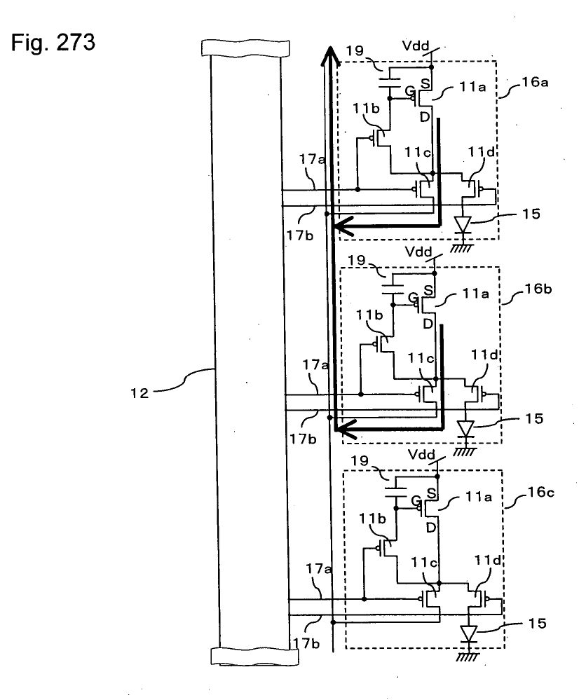

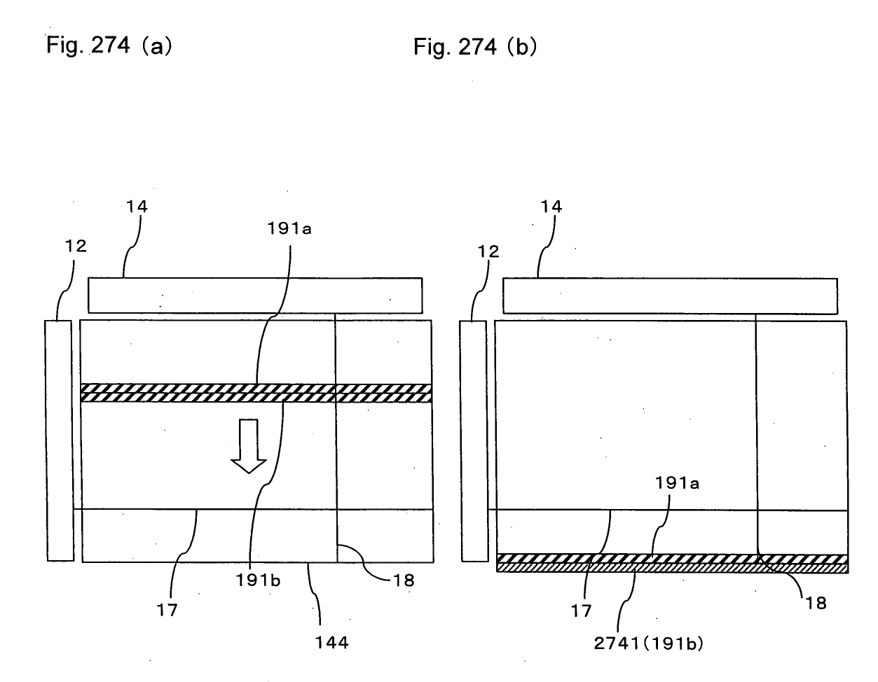

As shown in FIGS. 274(a) and (b), two write pixel rows 191 (191a and 191b) are selected in sequence from the upper side to the lower side of the screen 144 (see also FIG. 273. Pixel rows 16a and 16b are selected in FIG. 273). However, as shown in FIG. 274(b), at the bottom of the screen, there does not exist 191b although the write pixel row 191a exists. That is, there is only one pixel row to be selected. Thus, the current applied to the source signal line 18 is all written into the write pixel row 191a. Consequently, twice as large a current as usual is written into the write pixel row 191a.

To deal with this problem, the present invention forms (places) a dummy pixel row 2741 at the bottom of the screen 144, as shown in FIG. 274(b). Thus, after the pixel row at the bottom of the screen 144 is selected, the final pixel row of the screen 144 and the dummy pixel row 2741 are selected. Consequently, a prescribed current is written into the write pixel row in FIG. 274(b). Incidentally, although the dummy pixel row 2741 is illustrated as being adjacent to the top end or bottom end of the display area 144, this is not restrictive. It may be formed at a location away from the display area 144. Besides, the dummy pixel row 2741 does not need to contain a switching transistor 11d or EL element 15 such as those shown in FIG. 1. This reduces the size of the dummy pixel row 2741 and thereby reduces bevel width of the panel.

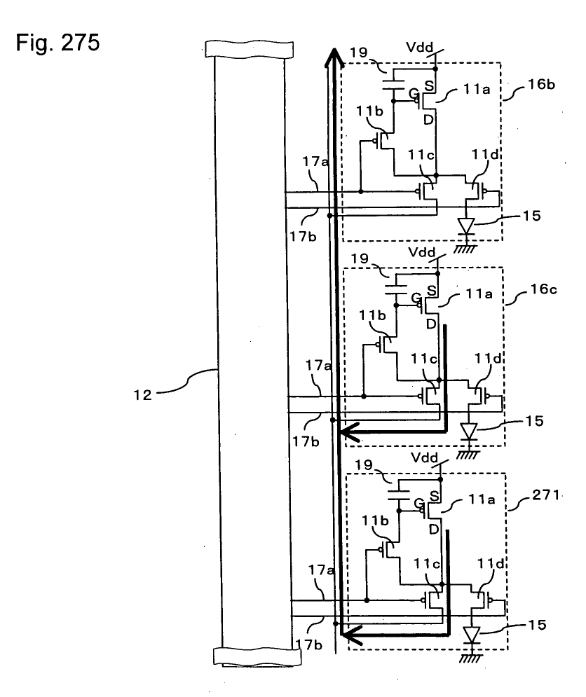

FIG. 275 shows a mechanism of how the state shown in FIG. 274(b) takes place. As can be seen from FIG. 275, after the pixel 16c at the bottom of the screen 144 is selected, the final pixel row 2741 of the screen 144 is selected. The dummy pixel row 2741 is placed outside the screen area 144. That is, the dummy pixel row 2741 does not illuminate, is not illuminated, or is hidden even if illuminated. For example, contact holes between the pixel electrode and transistor 11 are eliminated, no EL element 15 is formed on the dummy pixel row, or the like. Although the dummy pixel row 2741 shown in FIG. 275 contains the EL elements 15, transistors lid, gate signal lines 17b, these components are not needed to implement the drive method. No EL elements 15, transistor 11d or gate signal line 17b is formed in the dummy pixel row 2741 in the display panel actually developed according to the present invention. However, it is preferable to form pixel electrodes to allow for cases in which parasitic capacitance in a pixel is not equal to the parasitic capacitance in other pixels 16, causing differences in programming currents held by the pixels.

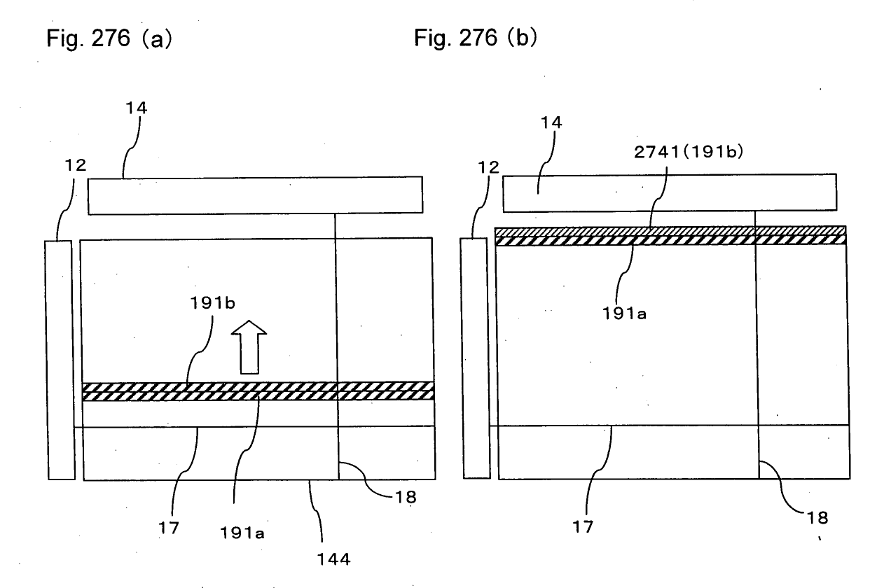

Although in FIGS. 274(a) and 274(b), the dummy pixel (row) 2741 is provided (formed or placed) along the bottom edge of the screen 144, this is not restrictive. For example, as shown in FIG. 276(a), it scans from the bottom edge to the top edge of the screen. If inverse scanning is used, a dummy pixel row 2741 should also be formed along the top edge of the screen 144 as illustrated in FIG. 276(b). That is, dummy pixel rows 2741 are formed (placed) both at the top and bottom of the screen 144. This configuration accommodates inverse scanning of the screen as well.

Two pixel rows are selected simultaneously in the example described above. The present invention is not limited to this. For example, five pixel rows may be selected simultaneously. When five pixel rows are selected simultaneously, four dummy pixel rows 2741 should be formed.

The number of dummy pixel rows 2741 may form M-1 pixel rows selected simultaneously. For example, if five pixel rows are selected simultaneously, the number of write pixel rows 191 is 4. If ten pixel rows are selected simultaneously, the number of write pixel rows is 10−1=9.

FIGS. 274 and 276 is an explanatory diagram illustrating placement locations of dummy pixel rows in the case where the dummy pixel rows 2741 are formed. Basically, assuming inversion driving, dummy pixel rows 2741 are placed at the top and bottom of the screen 144.

In the example described above, pixel rows are selected one by one and programmed with current, or two or more pixel rows are selected at a time and programmed with current. However, the present invention is not limited to this. It is also possible to use a combination of the two methods according to image data: the method of selecting pixel rows one by one and programming them with current and the method of selecting two or more pixel rows at a time and programming them with current.

Now, interlaced driving according to the present invention will be described below. FIG. 533 shows a configuration of the display panel according to the present invention which performs the interlaced driving. In FIG. 533., the gate signal lines 17a of odd-numbered pixel rows are connected to a gate driver circuit 12a1. The gate signal lines 17a of even-numbered pixel rows are connected to a gate driver circuit 12a2. On the other hand, the gate signal lines 17b of the odd-numbered pixel rows are connected to a gate driver circuit 12b1. The gate signal lines 17b of the even-numbered pixel rows are connected to a gate driver circuit 12b2.

Thus, through operation (control) of the gate driver circuit 12a1, image data in the odd-numbered pixel rows are rewritten in sequence. In the odd-numbered pixel rows, illumination and non-illumination of the EL elements are controlled through operation (control) of the gate driver circuit 12b1. Also, through operation (control) of the gate driver circuit 12a2, image data in the even-numbered pixel rows are rewritten in sequence. In the even-numbered pixel rows, illumination and non-illumination of the EL elements are controlled through operation (control) of the gate driver circuit 12b2.

FIG. 532(a) shows operating state in the first field of the display panel. FIG. 532(b) shows operating state in the second field of the display panel. Incidentally, for ease of understanding, it is assumed that one frame consists of two fields. In FIG. 532, the oblique hatching which marks the gate driver 12 indicates that the gate driver 12 are not taking part in data scanning operation. Specifically, in the first field in FIG. 532(a), the gate driver circuit 12a1 is operating for write control of programming current and the gate driver circuit 12b2 is operating for illumination control of the EL element 15. In the second field in FIG. 532(b), the gate driver circuit 12a2 is operating for write control of programming current and the gate driver circuit 12b1 is operating for illumination control of the EL element 15. The above operations are repeated within the frame.

FIG. 534 shows image display status in the first field. FIG. 534(a) illustrates write pixel rows (locations of odd-numbered pixel rows programmed with current (voltage)). The location of the write pixel row is shifted in sequence: FIG. 534(a1)→(a2)→(a3). In the first field, odd-numbered pixel rows are rewritten in sequence (image data in the even-numbered pixel rows are maintained). FIG. 534(b) illustrates display status of odd-numbered pixel rows. Incidentally, FIG. 534(b) illustrates only odd-numbered pixel rows. Even-numbered pixel rows are illustrated in FIG. 534(c). As can be seen from FIG. 534(b), the EL elements 15 of the pixels in the odd-numbered pixel rows are non-illuminated. On the other hand, the even-numbered pixel rows are scanned in both display area 193 and non-display area 192 as shown in FIG. 534(c).

FIG. 535 shows image display status in the second field. FIG. 535(a) illustrates write pixel rows (locations of odd-numbered pixel rows programmed with current (voltage)). The location of the write pixel row is shifted in sequence: FIG. 535(a1)→(a2)→(a3). In the second field, even-numbered pixel rows are rewritten in sequence (image data in the odd-numbered pixel rows are maintained). FIG. 535(b) illustrates display status of odd-numbered pixel rows. Incidentally, FIG. 535(b) illustrates only odd-numbered pixel rows. Even-numbered pixel rows are illustrated in FIG. 535(c). As can be seen from FIG. 535(b), the EL elements 15 of the pixels in the even-numbered pixel rows are non-illuminated. On the other hand, the odd-numbered pixel rows are scanned in both display area 193 and non-display area 192 as shown in FIG. 535(c).

In this way, interlaced driving can be implemented easily on an EL display panel. Also, N-fold pulse driving eliminates shortages of write current and blurred moving pictures. Besides, current (voltage) programming and illumination of EL elements 15 can be controlled easily and circuits can be implemented easily.

The drive method according to the present invention is not limited to those shown in FIGS. 534 and 535. For example, a drive method shown in FIG. 536 is also available. In FIGS. 534 and 535, the odd-numbered pixel rows or even-numbered pixel rows are programmed belong to a non-display area 192 (non-illumination or black display). The example in FIG. 536 involves synchronizing the gate driver circuits 12b1 and 12b2 which control illumination of the EL elements 15. Needless to say, however, the write pixel row 191 being programmed with current (voltage) belongs to a non-display area (there is no need for this in the case of the current-mirror pixel configuration in FIGS. 11 and 12).

In FIG. 536, since illumination control is common to the odd-numbered pixel rows and even-numbered pixel rows, there is no need to provide two gate driver circuits: 12b1 and 12b2. The gate driver circuit 12b alone can perform illumination control.

The drive method in FIG. 536 uses illumination control for both odd-numbered pixel rows and even-numbered pixel rows. However, the present invention is not limited to this. FIG. 537 shows an example in which illumination control varies between odd-numbered pixel rows and even-numbered pixel rows. Especially in FIG. 537, the illumination mode (display (illumination) area 193 and non-display (non-illumination) area 192) of odd-numbered pixel rows and illumination mode of even-numbered pixel rows have opposite patterns. Thus, display area 193 and non-display area 192 have the same size. However, this is not restrictive.

Also, in FIGS. 535 and 534, it is not strictly necessary that all the pixel rows in the odd-numbered pixel rows or even-numbered pixel rows should be non-illuminated.

In the above example, the drive method programs pixel rows with current (voltage) one at a time. However, the drive method according to the present invention is not limited to this. Needless to say, two pixel rows (a plurality of pixel rows) may be programmed with current (voltage) simultaneously as shown in FIG. 538 (see also FIGS. 274 to 276 and the descriptions). FIG. 538(a) shows an example concerning odd-numbered fields while FIG. 538(b) shows an example concerning an even-numbered fields. In odd-numbered fields, combinations of two pixel rows (1, 2), (3, 4), (5, 6), (7, 8), (9, 10), (11, 12), . . . , (n+1, n+2) are selected in sequence and programmed with current (where n is an integer not smaller than 1). In even-numbered fields, combinations of two pixel rows (2, 3), (4, 5), (6, 7), (8, 9), (10, 11), (12, 13), . . . , (n+1, n+2) are selected in sequence and programmed with current (where n is an integer not smaller than 1).

By selecting a plurality of pixel rows in each field and programming them with current, it is possible to increase the current to be passed through the source signal line 18, and thus write black properly. Also, by shifting combinations of pixel rows selected in odd-numbered fields and even-numbered fields at least by one pixel row, it is possible to increase the resolution of images.

Although in the example in FIG. 538, two pixel rows are selected in each field, this is not restrictive and three pixel rows maybe selected. In this case, the three pixel rows selected in both odd-numbered fields and even-numbered fields may be shifted by either one pixel row or two pixel rows. Also, four or more pixel rows may be selected in each field. Besides, one frame may be composed of three or more field.

Also, although in the example in FIG. 538, two pixel rows are selected simultaneously, this is not restrictive. It is possible to divide 1 H into a first ½ H and second ½ H and perform current programming in odd-numbered fields by selecting the first pixel row in the first ½ H of the first 1 H and selecting the second pixel row in the second ½ H of the first 1 H, selecting the third pixel row in the first ½ of the second 1 H and selecting the fourth pixel row in the second ½ of the second 1 H, selecting the fifth pixel row in the first ½ of the third 1 H and selecting the sixth pixel row in the second ½ of the third 1 H, and so on.

In even-numbered fields, current programming can be performed by selecting the second pixel row in the first ½ of the first 1 H and selecting the third pixel row in the second ½ of the first 1 H, selecting the fourth pixel row in the first ½ of the second 1 H and selecting the fifth pixel row in the second ½ of the second 1 H, selecting the sixth pixel row in the first ½ of the third 1 H and selecting the seventh pixel row in the second ½ of the third 1 H, and so on.

Again, although in the above example, two pixel rows are selected in each field, this is not restrictive and three pixel rows maybe selected. In this case, the three pixel rows selected in both odd-numbered fields and even-numbered fields may be shifted by either one pixel row or two pixel rows. Also, four pixel rows may be selected in each field.

The N-fold pulse driving method according to the present invention uses the same waveform for the gate signal lines 17b of different pixel rows and applies current by shifting the pixel rows at 1 H intervals. The use of such scanning makes it possible to shift illuminating pixel rows in sequence with the illumination duration of the EL elements 15 fixed to 1F/N. It is easy to shift pixel rows in this way while using the same waveform for the gate signal lines 17b of the pixel rows. It can be done by simply controlling data ST1 and ST2 applied to the shift register circuits 141a and 141b in FIG. 14. For example, if Vg1 is output to the gate signal line 17b when input ST1 is low and Vgh is output to the gate signal line 17b when input ST1 is high, ST2 applied to the shift register circuit 17b can be set low for a period of 1F/N and set high for the remaining period. Then, inputted ST2 can be shifted using a clock CLK2 synchronized with 1 H.

Since black display on EL display panel (EL display apparatus) corresponds to complete non-illumination, contrast does not lower unlike in the case of intermittent display on liquid crystal display panels. Also, with the configurations in FIGS. 1, 6, 7, 8, 9, 10, 11, 12, 28 and 271, intermittent display can be achieved by simply turning on and off the transistor 11d or transistor 11e or switch (circuit) 71. This is because image data is stored in the capacitor 19 (the number of gradations is infinite because analog values are used). That is, the image data is held in each pixel 16 for a period of 1F. Whether to deliver a current which corresponds to the stored image data to the EL element 15 is controlled by controlling the transistors 11d and 11e, or the like.

Thus, the drive method described above is not limited to a current-driven type and can be applied to a voltage-driven type as well. That is, in a configuration in which the current passed through the EL element 15 is stored in each pixel, intermittent driving is implemented by switching on and off the current path between the driver transistor 11 and EL element 15.

It is important to maintain terminal voltage of the capacitor 19 in order to reduce flickering and power consumption. This is because if the terminal voltage of the capacitor 19 changes (charge/discharge) during one field (frame) period, flickering occurs when the screen brightness changes and the frame rate lowers. The current passed through the EL element 15 by the transistor 11a must be higher than 65%. More specifically, if the initial current written into the pixel 16 and passed through the EL element 15 is taken as 100%, the current passed through the EL element 15 just before it is written into the pixel 16 in the next frame (field) must not fall below 65%.

With the pixel configuration shown in FIG. 1, there is no difference in the number of transistors 11 in a single pixel between when an intermittent display is created and when an intermittent display is not created. That is, leaving the pixel configuration as it is, proper current programming is achieved by removing the effect of parasitic capacitance of the source signal line 18. Besides, movie display close to that of a CRT is achieved.

Also, since the operation clock of the gate driver circuit 12 is significantly slower than the operation clock of the source driver circuit (IC) 14, there is no need to upgrade the main clock of the circuit. Besides, the value of N can be changed easily.

Incidentally, the image display direction (image writing direction) may be from top to bottom of the screen in the first field (frame), and from bottom to top of the screen in the second field (frame). That is, an upward direction and downward direction may be repeated alternately. Also, it is possible to use a downward direction in the first field (frame), turn the entire screen into black display (non-display) once, and use an upward direction in the second field (frame). It is also possible to turn the entire screen into black display (non-display) once. It is also possible to scan from the center of the screen. It is also possible to make the position where the scanning starts at random. Incidentally, although top-to-bottom and bottom-to-top writing directions on the screen are used in the drive method described above, this is not restrictive. It is also possible to fix the writing direction on the screen to a top-to-bottom direction or bottom-to-top direction and move the non-display area 192 from top to bottom in the first field, and from bottom to top in the second field. Alternatively, it is possible to divide a frame into three fields and assign the first field to R, the second field to G, and the third field to B so that three fields compose a single frame. It is also possible to display R, G, and B in turns by switching among them every horizontal scanning period (1 H) (see FIGS. 25 to 39 and their description). The items mentioned above also apply to other examples of the present invention.

The non-display area 192 need not be totally non-illuminated. Weak light emission or dim image display will not be a problem in practical use. It should be regarded to be an area which has a lower display brightness than the image display (illumination) area 193. Also, the non-display area 192 may be an area which does not display one or two colors out of R, G, and B. Also, it may be an area which displays one or two colors among R, G, and B at low brightness.

Basically, if the brightness of the display area 193 is kept at a predetermined value, the larger the display area 193, the brighter the display screen 144. For example, when the brightness of the image display area 193 is 100 (nt), if the percentage of the entire display screen 144 accounted for by the display area 193 changes from 10% to 20%, the brightness of the screen is doubled. Thus, by varying the proportion of the display area 193 in the entire display screen 144, it is possible to vary the display brightness of the screen. The display brightness of the display screen 144 is proportional to the ratio of the display area 193 to the display screen 144.

The size of the display area 193 can be specified freely by controlling data pulses (ST2) sent to the shift register circuit 141 as shown in FIG. 14. Also, by varying the input timing and period of the data pulses, it is possible to switch between the display condition shown in FIG. 23 and display condition shown in FIG. 19. Increasing the number of data pulses in one IF period makes the display screen 144 brighter and decreasing it makes the display screen 144 dimmer. Also, continuous application of the data pulses brings on the display condition shown in FIG. 19 while intermittent application of the data pulses brings on the display condition shown in FIG. 23.

In brightness adjustment of a conventional screen, low brightness of the screen 144 results in poor gradation performance. That is, even if 64 gradations can be displayed in a high-brightness display, in most cases, less than half the gradations can be displayed in a low-brightness display. In contrast, the drive method according to the present invention does not depend on the display brightness of the screen and can display up to 64 gradations, which is the highest.

Mainly, N=two times, N=4 times, etc. are used in the above example. Needless to say, however, the present invention is not limited to integral multiples. It is not limited to a value equal to or larger than N=one, either. For example, less than half the screen 144 may be a non-display area 192 at a certain time point. A predetermined brightness can be achieved if a current Iw 5/4 a predetermined value is used for current programming and the EL element is illuminated for ⅘ of 1F.

The present invention is not limited to the above. For example, a current Iw 10/4 a predetermined value may be used for current programming to illuminate the EL element for ⅘ of 1F. In this case, the EL element illuminates at twice a predetermined brightness. Alternatively, a current Iw 5/4 a predetermined value may used for current programming to illuminate the EL element for ⅖ of 1F. In this case, the EL element illuminates at ½ the predetermined brightness. Also, a current Iw 5/4 a predetermined value may be used for current programming to illuminate the EL element for 1/1 of 1F. In this case, the EL element illuminates at 5/4 the predetermined brightness. Also, a current Iw 1 a predetermined value may be used for current programming to illuminate the EL element for ¼ of 1F. In this case, the EL element illuminates at ¼ the predetermined brightness.

Thus, the present invention controls the brightness of the display screen by controlling the magnitude of programming current and illumination period IF. Also, by illuminating the EL element for a period shorter than the period of 1F, the present invention can insert a black display 192, and thereby improve movie display performance. On the other hand, when N is not smaller than 1, by illuminating the EL element constantly for the period of 1F, the present invention can display a bright screen.

If pixel size is A square mm and predetermined brightness of white raster display is B (nt), preferably programming current I (μA) (programming current outputted from the source driver circuit (IC) 14 or the current written into the pixel satisfies:
(A×B)/20≦I≦(A×B)

This provides good light emission efficiency and solves a shortage of write current.

More preferably, the programming current I (μA) falls within the range:
(A×B)/10≦I≦(A×B)

In FIGS. 20 and 24, no mention is made of operation timing of the gate signal line 17a or write timing of the gate signal line 17b. However, if a certain pixel is selected (a turn-on voltage is applied to the gate signal line 17a connected with the pixel), a turn-off voltage is applied to the gate signal line 17b (the gate signal line which controls the EL-side transistor 11d) during the previous 1H period (one horizontal scanning period) and the next 1H period. The application of a turn-off voltage to the gate signal line 17b during the previous 1H period and the next 1H period makes it possible to achieve stable image display without cross-talk.

A timing chart of this drive method is shown in FIG. 26, in which a turn-on voltage (Vgl) is applied to the gate signal line 17 for 1 H (selection period). A turn-off voltage (Vgh) is applied to the gate signal line 17b for 1H period before and 1H period after the 1H period during which the pixel is selected (for a total of 3H periods).

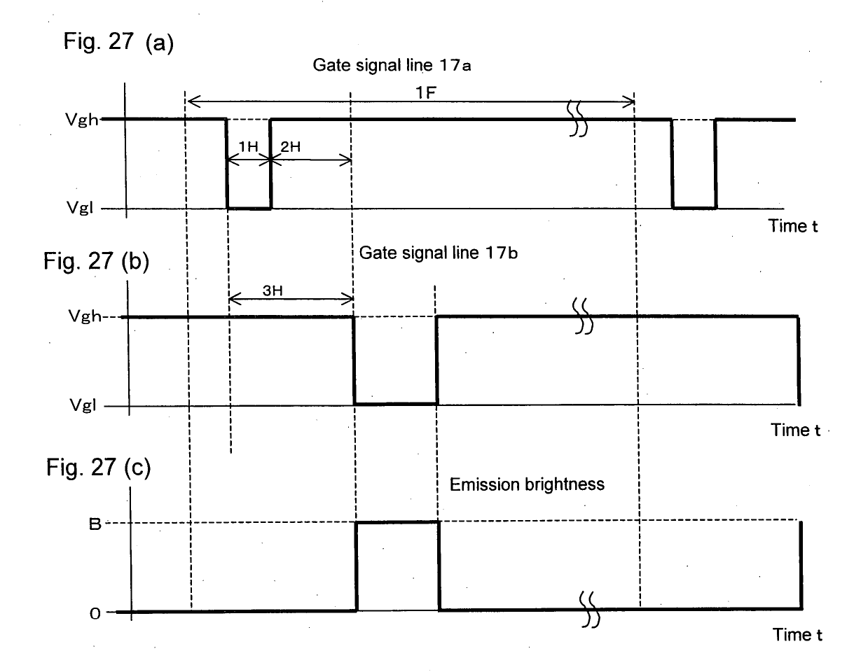

In the above example, a turn-off voltage is applied to the gate signal line 17b for 1H period both before and after a selection period. However, the present invention is not limited to this. For example, as illustrated in FIG. 27, a turn-off voltage may be applied to the gate signal line 17b for 1H period before and 2H periods after the selection period. Needless to say, this also applies to other examples of the present invention.

Incidentally, the EL elements 15 must be turned on and off at intervals of 0.5 msec or longer. Short intervals will lead to insufficient black display due to persistence of vision, resulting in blurred images and making it look as if the resolution has lowered. This also represents a display state of a data holding display. However, increasing the on/off intervals to 100 msec will cause flickering. Thus, the on/off intervals of the EL elements must be not shorter than 0.5 μsec and not longer than 100 msec. More preferably, the on/off intervals should be from 2 msec to 30 msec (both inclusive). Even more preferably, the on/off intervals should be from 3 msec to 20 msec (both inclusive).

As also described above, an undivided black screen 192 achieves good movie display, but makes flickering of the screen more noticeable. Thus, it is desirable to divide the black insert into multiple parts. However, too many divisions will cause moving pictures to blur. The number of divisions should be from 1 to 8 (both inclusive). More preferably, it should be from 1 to 5 (both inclusive).

Incidentally, it is preferable that the number of divisions of a black screen can be varied between still pictures and moving pictures. When N=4, 75% is occupied by a black screen and 25% is occupied by image display. When the number of divisions is 1, a strip of black display which makes up 75% is scanned vertically. When the number of divisions is 3, three blocks are scanned, where each block consists of a black screen which makes up 25% and a display screen which makes up 25/3 percent. The number of divisions is increased for still pictures and decreased for moving pictures. The switching can be done either automatically according to input images (detection of moving pictures) or manually by the user.

For example, for wallpaper display or an input screen on a cell phone, the number of divisions should be 10 or more (in extreme cases, the display may be turned on and off every 1 H). When displaying moving pictures in NTSC format, the number of divisions should be from 1 to 5 (both inclusive). Preferably, the number of divisions can be switched in three or more steps; for example, 0, 2, 4, 8 divisions, and so on Preferably, the ratio of the black screen to the entire display screen 144 should be from 0.2 to 0.9 (from 1.2 to 9 in terms of N) both inclusive when the area of the entire screen is taken as 1. More preferably, the ratio should be from 0.25 to 0.6 (from 1.25 to 6 in terms of N) both inclusive. If the ratio is 0.20 or less, movie display is not improved much. When the ratio is 0.9 or more, the display part becomes bright and its vertical movements become liable to be recognized visually.

Also, preferably, the number of frames per second is from 10 to 100 (10 Hz to 100 Hz) both inclusive. More preferably, it is from 12 to 65 (12 Hz to 65 Hz) both inclusive. When the number of frames is small, flickering of the screen becomes conspicuous while too large a number of frames makes writing from the source driver circuit (IC) 14 and the like difficult, resulting in deterioration of resolution.

In the case of the still image, it is desirable to disperse the non-display areas 192 into a large number as shown in FIGS. 23, 54(c) and 468(c). In the case of the dynamic image, it is desirable to integrate the non-display areas as shown in FIGS. 23, 54(a) and 468(a).

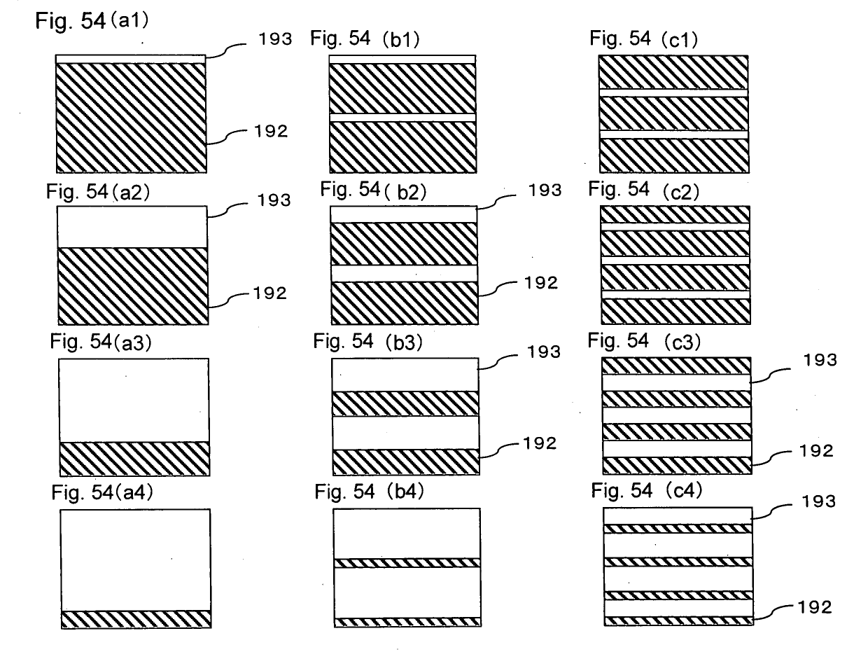

In the case of a natural image such as a movie, the dynamic image and still image are continuously displayed. Therefore, it is necessary to switch from the dynamic image to the natural image and from the natural image to the dynamic image. If FIGS. 23, 54(c) and 468(c) of the still images and FIGS. 23, 54(a) and 468(a) of the dynamic images are suddenly changed, the flicker occurs. This problem should be handled by means of the intermediate moving image (FIGS. 468(b) and 54(b)). For instance, it is not desirable to make a rapid change when shifting from FIG. 468(a) to the intermediate moving image 468(b). The non-display area 192a (refer to FIG. 468(b)) is generated from the center of the display area 193a of FIG. 468(a), and the area of A of the non-display area 192a is gradually expanded (in the case where the image contents do not change, it is necessary to maintain a total of the area of the display areas 193). In the case where the still images further continue, the non-display areas 192 are divided, the portion B is gradually expanded and the display area 193 is divided into a plurality as in FIG. 468(c). When shifting from the still image to the moving image, an inverse driving method (display method or control method) is implemented. The above manipulation or operation prevents the flicker from occurring on shifting from the still image to the moving image or on shifting inversely.

In the case of the still image, the non-display areas 192 are dispersed into a large number as shown in FIGS. 23, 54(c) and 468(c). In the case of the dynamic image, the non-display areas are integrated as shown in FIGS. 23, 54(a) and 468(a). As will be described later, however, it cannot be primarily decided due to combination with the duty ratio control or the reference current ratio control.

For instance, there may be no non-display area 192 when the duty ratio is 1/1 in the case of the dynamic image. When the duty ratio is 0/1 in the case of the still image, the entire screen 144 may be the non-display area 192 so that the non-display area 192 cannot be divided. When the duty ratio is small (close to 0/1) in the case of the dynamic image, the non-display area 192 may be divided into a plurality. When the duty ratio is large (close to 1/1) in the case of the still image, there may be no non-display area 192 on the entire screen 144 so that the non-display area 192 cannot be divided. Therefore, it was described as an example for description purpose that the non-display areas 192 are dispersed into a large number as shown in FIGS. 23, 54(c) and 468(c) in the case of the still image, and the non-display areas are integrated as shown in FIGS. 23, 54(a) and 468(a) in the case of the dynamic image. There are many deformed examples.

Therefore, with respect to the book, according to the driving method of the invention, the display apparatus of the present invention is driven, when displaying a number of displays (a drama, a movie and so on) thereon, so that there is a scene at least once in which the non-display areas 192 are dispersed into a large number as shown in FIGS. 23, 54(c) and 468(c) in the case of the still image, and there is a scene at least once in which the non-display areas are integrated as shown in FIGS. 23, 54(a) and 468(a) in the case of the dynamic image.

The gate signal line 17b may be set to Vg1 for a period of 1F/N anytime during the period of 1F (not limited to 1F. Any unit time will do). This is because a predetermined brightness is obtained by turning off the EL element 15 for a predetermined period out of a unit time. However, it is preferable to set the gate signal line 17b to Vg1 and illuminate the EL element 15 immediately after the current programming period (1 H) This will reduce the effect of retention characteristics of the capacitor 19 in FIG. 1.

Preferably, the drive voltage should be varied between the gate signal line 17a which drives the transistors 11b and 11c and the gate signal line 17b which drives the transistor 11d. The amplitude value (difference between turn-on voltage and turn-off voltage) of the gate signal line 17a should be smaller than the amplitude value of the gate signal line 17b.

Too large an amplitude value of the gate signal line 17a will increase penetration voltage between the gate signal line 17a and pixel 16, resulting in an insufficient black level. The amplitude of the gate signal line 17a can be controlled by controlling the time when the potential of the source signal line 18 is applied to the pixel 16. Since changes in the potential of the source signal line 18 are small, the amplitude value of the gate signal line 17a can be made small.

On the other hand, the gate signal line 17b is used for on/off control of EL element 15. Thus, its amplitude value becomes large. For this, output voltage is varied between the shift register circuit circuits 141a and 141b in FIG. 6. If the pixel is constructed of P-channel transistors, approximately equal Vgh (turn-off voltage) is used for the shift register circuits 141a and 141b while Vgl (turn-on voltage) of the shift register circuit 141a is made lower than Vgl (turn-on voltage) of the shift register circuit 141b.

In the above example, one selection pixel row is placed (formed) per pixel row. The present invention is not limited to this and a gate signal line 17a may be placed (formed) for two or more pixel rows.

FIG. 22 shows such an example. Incidentally, for ease of explanation, the pixel configuration in FIG. 1 is employed mainly. In FIG. 22, the gate signal line 17a for pixel row selection selects three pixels (16R, 16G, and 16B) simultaneously. Reference character R is intended to indicate something related to a red pixel, reference character G indicates something related to a green pixel, and reference character B indicates something related to a blue pixel.

When the gate signal line 17a is selected, the pixels 16R, 16G, and 16B are selected and get ready to write data. The pixel 16R writes video data into a capacitor 19R via a source signal line 18R, the pixel 16G writes video data into a capacitor 19G via a source signal line 18G, and the pixel 16B writes video data into a capacitor 19B via a source signal line 18B.

The transistor 11d of the pixel 16R is connected to a gate signal line 17bR, the transistor 11d of the pixel 16G is connected to a gate signal line 17bG, and the transistor 11d of the pixel 16B is connected to a gate signal line 17bB. An EL element 15R of the pixel 16R, EL element 15G of the pixel 16G, and EL element 15B of the pixel 16B can be turned on and off separately illumination times and illumination periods of the EL element 15R, EL element 15G, and EL element 15B can be controlled separately by controlling the gate signal line 17bR, gate signal line 17bG, and gate signal line 17bB.

To implement this operation, in the configuration in FIG. 6, it is appropriate to form (place) four shift register circuits: a shift register circuit 141 which scans the gate signal line 17a, shift register circuit 141R (not shown in the drawing) which scans the gate signal line 17bR, shift register circuit 141G (not shown in the drawing) which scans the gate signal line 17bG, and shift register circuit 141B (not shown in the drawing) which scans the gate signal line 17bB.

Although it has been stated that a current N times larger than a predetermined current is passed through the source signal line 18 and that a current N times larger than a predetermined current is passed through the EL element 15 for a period of 1/N, this cannot be implemented in practice. Actually, signal pulses applied to the gate signal line 17 penetrate into the capacitor 19, making it impossible to set a desired voltage value (current value) on the capacitor 19. Generally, a voltage value (current value) lower than a desired voltage value (current value) is set on the capacitor 19. For example, even if 10 times larger current value is meant to be set, only equal to or lower than 10 times larger current value is set on the capacitor 19. For example, even if N=10 is specified, N=lower than 10 times larger current actually flows through the EL element 15.

However, for ease of explanation, it will be described in the ideal situation which there is no affects by the voltage. Practically, this method sets an N times larger current value to pass a current proportional or corresponding to the N-fold value through the EL element 15.

The present invention performs current (voltage) programming so as to obtain desired emission brightness of the EL element by passing a current larger than a desired value intermittently through the driver transistor 11a (in the case of FIG. 1) (i.e., a current which will give brightness higher than the desired brightness if passed through the EL element 15 continuously).

It is also useful to use P-channel transistors as the switching transistors 11b and 11c in FIG. 1 to cause penetration, and thereby obtain a proper black display. When the P-channel transistor 11b turns off, the voltage goes high (Vgh), shifting the terminal voltage of the capacitor 19 slightly to the Vdd side. Consequently, the voltage at the gate (G) terminal of the transistor 11a rises, resulting in more intense black display. Also, the current used for first gradation display can be increased (a certain base current can be delivered up until gradation 1), and thus shortages of write current can be eased during current programming.

The transistor 11b in FIG. 1 operates such that the current flowing through the driver transistor 11a is held in the capacitor 19. That is, it has a function to short-circuit the gate terminal (G) of the driver transistor 11a with the drain terminal (D) or source terminal (S) during programming.

The source terminal (S) or drain terminal (D) of the transistor 11b is connected with the holding capacitor 19. The transistor 11b is subjected to on/off control by means of the voltage applied to the gate signal line 17a. The problem is that the voltage of the gate signal line 17a penetrates into the capacitor 19 when a turn-off voltage is applied. The potential of the capacitor 19 (potential at the gate terminal (G) of the driver transistor 11a) is changed by the penetration voltage. This makes it impossible to compensate for characteristics of the transistor 11a using programming current. Thus, the penetration voltage must be reduced.

To reduce the penetration voltage, the size of the transistor 11b can be reduced. Suppose, Scc=W*L (square μm), where Scc is transistor size, W (μm) is channel width, and L (μm) is channel length. If a plurality of transistors are connected in series, Scc represents the total size of the connected transistors. For example, if four transistors (n=4) each of which measures 5 μm in W and 6 μm in L are connected, Scc=5×6×4=120 (square μm).

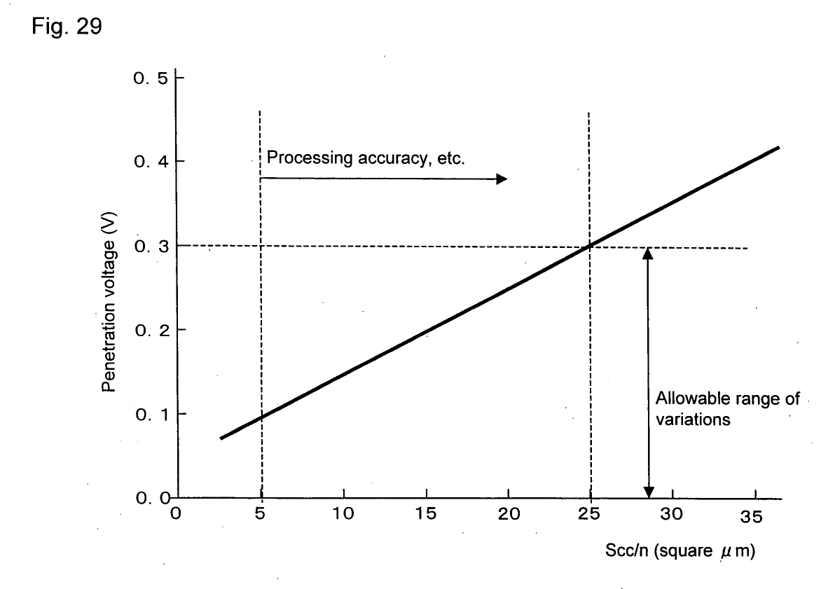

There is a correlation between transistor size and penetration voltage. This relationship is shown in FIG. 29. It is assumed that the transistors are P-channel transistors. However, this similarly applies to N-channel transistors.

In FIG. 29, the horizontal axis represents Scc/n, i.e., Scc divided by n. As described above Scc/n is the sum of transistor sizes where n represents the number of connected transistors. In FIG. 29, the horizontal axis represents Scc divided by n, that is, the size of one transistor.

In the above example, in which the transistor size Scc is given as the product of channel width W (μm) and channel length L (μm), if the number of transistors is 4 (n=4), then Scc/n=5×6×4/4=30 (square μm). In FIG. 29, the vertical axis represents penetration voltage (V).

The penetration voltage must be 0.3 V or lower. A higher penetration voltage will cause laser shot irregularities, resulting in visually unallowable images. Thus, the size of one transistor should be 25 square μm or less. On the other hand, a transistor smaller than 5 square μm will degrade processing accuracy of the transistor, resulting in large variations. Also, transistor size outside the above range will adversely affect driving capacity. Thus, the transistor size should be within 5 and 25 square μm (both inclusive). More preferably, it should be within 5 and 20 square μm (both inclusive).

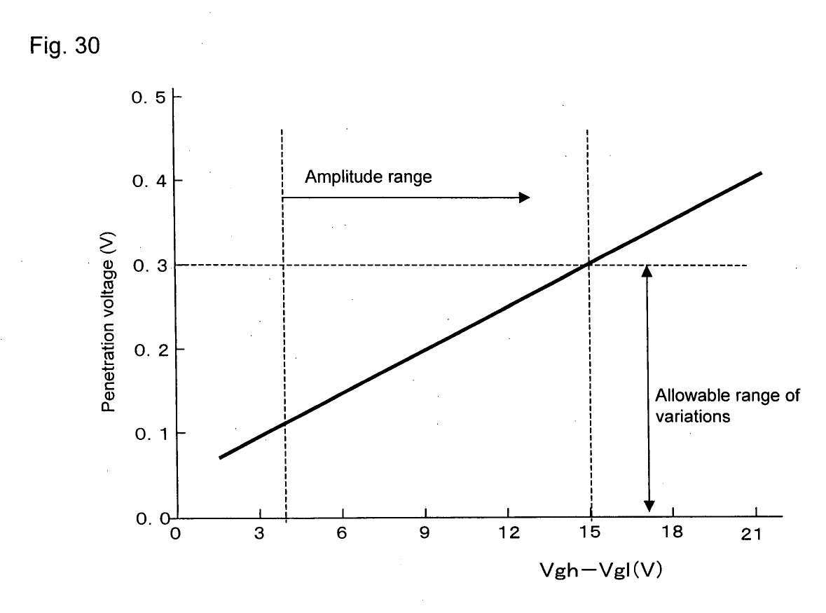

The penetration voltage caused by a transistor is also correlated with the amplitude value (Vgh−Vgl) of the voltages (Vgh and Vgl) which drive the transistor. The larger the amplitude value, the higher the penetration voltage. This relationship is shown in FIG. 30, in which the horizontal axis represents the amplitude value (Vgh−Vgl). The vertical axis represents the penetration voltage. As also described with reference to FIG. 29, the penetration voltage must be 0.3 V or lower.

In other words, the permissible value (0.3 V) of penetration voltage is equal to or smaller than ⅕ (20%) the amplitude value of the source signal line 18. The voltage of the source signal line 18 is 1.5 V when the programming current is intended for white display, and 3.0 V when the programming current is intended for black display. Thus, 3.0−1.5/5=0.3 (V).

On the other hand, unless the amplitude value (Vgh−Vgl) of the gate signal line is 4 (V) or more, sufficient current cannot be written into the pixel 16. Thus, the amplitude value (Vgh−Vgl) of the gate signal line should be between 4 V and 15 V (both inclusive). More preferably, the amplitude value (Vgh−Vgl) of the gate signal line is between 5 V and 12 V (both inclusive).

If a plurality of transistors 11b are connected in series, it is preferable to increase the channel length L of the transistor (referred to as the transistor 11bx) nearest to the gate terminal (G) of the driver transistor 11a. If the voltage applied to the gate signal line 17a changes from turn-on voltage (Vgl) to turn-off voltage (Vgh), the transistor 11bx is turned off earlier than the other transistors 11b. This reduces the effect of penetration voltage. For example, if the channel width W of the plurality of transistors 11b and the transistor 11bx is 3 μm, the channel length L of the plurality of transistors 11b (the transistors other than the transistor 11bx) is 5 μm and the channel length Lx of the transistor 11bx is 10 μm. The transistors 11b are placed beginning with the one nearest to the transistor 11c and the transistor 11bx is placed on the side of the gate terminal (G) of the driver transistor 11a.

Preferably, the channel length Lx of the transistor 11bx is not smaller than 1.4 times and not larger than 4 times the channel length L of the transistors 11b. More preferably, the channel length Lx of the transistor 11bx is not smaller than 1.5 times and not larger than 3 times the channel length L of the transistors 11b.

The penetration voltage depends on voltage amplitude of the gate driver circuit 12a which selects pixels 16. That is, it depends on the potential difference between the turn-on voltage (Vgl1) and turn-off voltage (Vgh1) in the pixel configuration in FIG. 1. The smaller the potential difference, the smaller the penetration voltage to the capacitor 19, and thus the smaller the potential shift at the gate terminal of the transistor 11a.

A small potential difference between Vgl1 and Vgh1 is effective in reducing “penetration voltage,” but disables the transistor 11c from turning on completely. For example, with the pixel configuration in FIG. 1, when the voltages applied to the source signal line 18 range between 5 V and 0 V, preferably the voltages applied to the gate signal line 17a are equal to or higher than +6 V ('2 Vgh1) and equal to or lower than −2 V (=Vgl1). By applying such voltages to the gate signal line 17a, it is possible to maintain good on/off state of the transistor 11c which acts as a selector switch.

On the other hand, almost no current flows through the transistor 11b which performs current programming of the driver transistor 11a. Thus, there is no need to operate the transistor 11b as a switch. That is, the transistor 11b does not need to turn on sufficiently. The transistor 11b operates satisfactorily even if the turn-on voltage (Vgl1) is high.

Although penetration voltage is described herein by citing the pixel configuration in FIG. 1, this is not restrictive. Needless to say, for example, the method described above can also be used for other configurations such as the current-mirror configurations in FIGS. 11, 12, and 13, 375(b). It goes without saying that the above items also apply to other examples of the present invention.

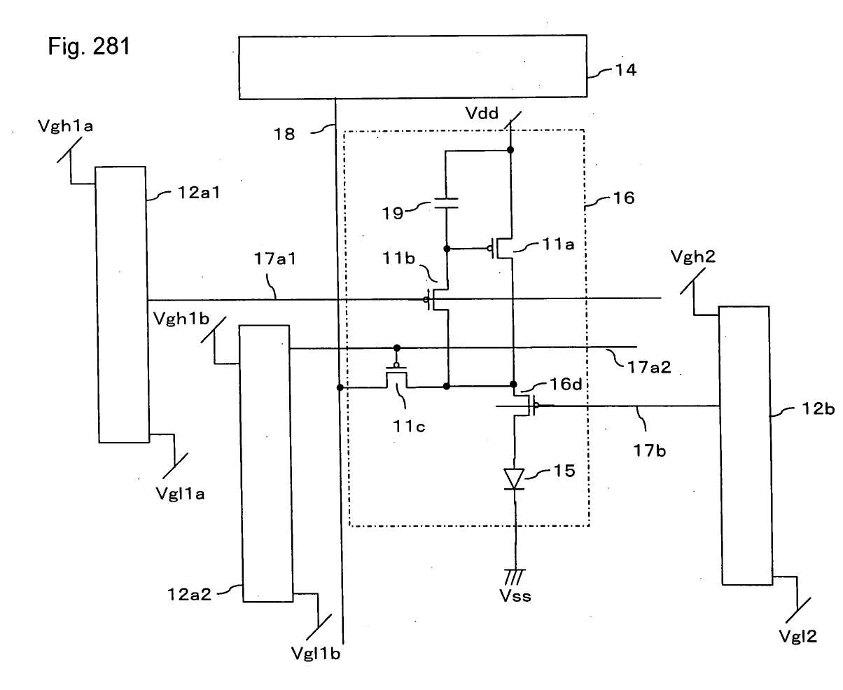

As can be seen from the foregoing description, it is preferable to separate the gate signal line 17a1 which controls the transistor 11b and the gate signal line 17a2 which operates the transistor 11c as illustrated in FIG. 281 rather than operating the transistors 11b and 11c simultaneously using the gate signal line 17a.

The gate driver circuit (IC) 12a1 controls the gate signal line 17a1 while the gate driver circuit (IC) 12a2 controls the gate signal line 17a2. The gate signal line 17a1 controls the on/off state of the transistor 11b using a turn-on voltage Vgh1a and a turn-off voltage Vgl1a. The gate signal line 17a2 controls the on/off state of the transistor 11c using a turn-on voltage Vgh1b and turn-off voltage Vgl1b.

By reducing the amplitude value |Vgh1a−Vgl1a| of the gate signal line 17a1, it is possible to reduce the penetration voltage to the capacitor 19 caused by the parasitic capacitance of the transistor 11b. By increasing the amplitude value |Vgh1b−Vgl1b| of the gate signal line 17a2, it is possible to make the transistor 11c turn on and off completely, operating as a good switch. The relationship between |Vgh1a−Vgl1a| and |Vgh1a−Vgl1a| is defined or built such that a relationship |Vgh1a−Vgl1a|<|vgh1a−Vgl1a | will be maintained.

Preferably, the turn-off voltage Vgh1 is identical to turn-off voltage Vgh2. This will decrease the number of power supplies, thereby reducing circuit costs. Also, by basing the turn-off voltage Vgh1 on the anode voltage Vdd, it is possible to stabilize the operation of the transistors 11.

On the other hand, preferably the turn-on voltage Vgl1 of the gate driver circuit (IC) 12a1 is kept within +1 V to −6 V (both inclusive) of the ground voltage (GND) of the source driver circuit (IC) 14. This will reduce penetration voltage, achieving good uniform display.

Furthermore, preferably the turn-on voltage Vgl2 of the gate driver circuit (IC) 12a2 is kept within 0 V to −10 V (both inclusive) of the ground voltage (GND) of the source driver circuit (IC) 14. This will allow the transistor 11c to turn on completely, making it possible to achieve proper current (voltage) programming. Also, it is preferable that Vgl2 is lower than Vgl1 by 1 V or more.

Preferably a turn-off voltage is applied to a gate signal line 17a with the following timing after a turn-on voltage is applied to a gate signal line 17a to select a pixel row. Specifically, a turn-off voltage (Vgh1b) should be applied to the gate signal line 17a2 0.05 μsec to 10 μsec (or 1/400 to 1/10 of 1 H) (both inclusive) after a turn-off voltage (Vgh1a) is applied to the gate signal line 17a1. By turning off the transistor 11b before the transistor 11c, it is possible to reduce the effect of penetration voltage greatly.

Although the two gate driver circuits 12a1 and 12a2 are illustrated in FIG. 281, this is not restrictive and they may be provided as a unit. This also applies to relationship between the gate driver circuits 12a and 12b. The gate driver circuit 12 may be provided as a unit, for example, as illustrated in FIG. 14. Needless to say, this also applies to other examples of the present invention.

What is described in the above examples is not limited to the pixel configuration in FIG. 1. For example, it is not needless to say that this also applies to the pixel configuration shown in FIGS. 6, 7, 8, 9, 10, 11, 12, 13, 28, 31, 36, 193, 194, 215, 314(a) (b), 607(a) (b) (c), or the like. That is, the voltage change which drives the gate terminal (the gate terminal of the transistor 11b in FIG. 1) of a transistor connected to a voltage-holding capacitor 19 is varied from the voltage change which drives the gate terminal (the gate terminal of the transistor 11c in FIG. 1) of a pixel selection transistor.

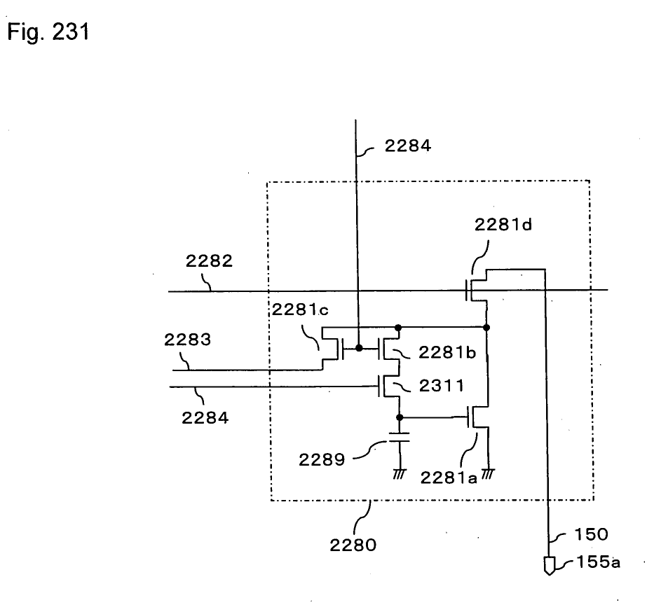

Although the operation of transistors in pixels 16 has been described in the above example, needless to say, the present invention is not limited to pixels and is also applicable to a holding circuit 2280 (described with reference to FIG. 231) and the like because these components have similar configurations and are based on the same technical idea.

In the above example, the driver transistor 11a is a P-channel transistor. When the driver transistor 11a is an N-channel transistor, the present invention can be applied by adjusting the potentials of the turn-on voltage and turn-off voltage accordingly, and thus description will be omitted.

With the pixel configurations described with reference to FIG. 1 and the like, there is one driver transistor 11a for each pixel. However, the number of driver transistors 11a according to the present invention is not limited to one. Examples include a pixel configuration in FIG. 31.

FIG. 31 shows an example in which a pixel 16 has six transistors: a programming transistor 11an is connected to a source signal line 18 via two transistors 11b2 and 11c and a driver transistor 11a1 is connected to the source signal line 18 via two transistors 11b1 and 11c.

In FIG. 31, the driver transistor 11a1 and programming transistor 11an share a common gate terminal. The transistor 11b1 acts to short-circuit the drain and gate terminals of the driver transistor 11a1 during current programming. The transistor 11b2 acts to short-circuit the drain and gate terminals of the programming transistor 11an during current programming.

The transistor 11c is connected to the gate terminal of the driver transistor 11a1. The transistor 11d is formed or placed between the driver transistor 11a1 and EL element 15 to control the current flowing through the EL element 15. An additional capacitor 19 is formed or placed between the gate terminal and anode (Vdd) terminal of the driver transistor 11a1. The source terminals of the driver transistor 11a1 and programming transistor 11an are connected to the anode (Vdd) terminal.

If the current flowing through the driver transistor 11a1 and current flowing through the programming transistor 11an are passed through the same number of transistors as described above, it is possible to improve accuracy. That is, the current flowing through the driver transistor 11a1 flows to the source signal line 18 via the transistor 11b1 and transistor 11c. On the other hand, the current flowing through the programming transistor 11an flows to the source signal line 18 via the transistor 11b2 and transistor 11c. Thus, the current from the driver transistor 11a1 and current from the programming transistor 11an flow to the source signal line 18 via the same number of transistors, namely two transistors.

Although only one driver transistor 11an is shown in FIG. 31, this is not restrictive. There may be two or more driver transistors 11an of the same channel width W and same channel length L, or two or more driver transistors 11an with the same WL ratio. Preferably, it has either the same channel width W and same channel length L or the same WL ratio as the driver transistor 11an of the driver transistor 11a1. The use of transistors of the same WL or with the same WL ratio is preferable because it reduces output variations among the transistors 11a, thereby reducing variations among the pixels 16.

When a selection voltage (turn-on voltage) is applied to the gate signal line 17a, the current from the transistor 11an and current from the transistor 11a1 are combined into a programming current Iw. The programming current Iw bears a predetermined ratio to the current Ie flowing from the driver transistor 11a1 to the EL element 15.

Iw=n*Ie (n is a natural number equal to or more than one)

In the above equation, if B (nt) is the display brightness of maximum white raster on the display panel, S (square millimeters) is the pixel area on the display panel (R, G, and B are treated as a unit. Thus, if each of R, G, and B picture elements measures 0.1 mm (L) and 0.05 (W), S=0.1×(0.05×3) square millimeters), and H (milliseconds) is one pixel selection period (one horizontal scanning (1H) period), the following condition should be satisfied. The display brightness B is the maximum displayable brightness prescribed by panel specification.
5≦(B*S)/(n*H)≦150

More preferably, the following condition should be satisfied.
10≦(B*S)/(n*H)≦100

Iw is the programming current outputted by the. source driver circuit (IC) 14. The voltage corresponding to this programming current is held by the capacitor 19 of the pixel 16. On the other hand, Ie is the current passed through the EL element 15 by the driver transistor 11a1.

Variations in the output of the transistor 11a1 and transistor 11an can be reduced by forming or placing the transistor 11an and driver transistor 11a1 close to each other. Also, the characteristics of the transistor 11an and transistor 11a1 may vary with their formation direction. Thus, preferably the transistors are formed in the same orientation.

When the gate signal line 17a is turned on, both driver transistor 11a1 and programming transistor 11an turn on. Preferably, the current Iw1 passed by the driver transistor 11a1 and current Iw2 passed by the programming transistor 11a1 are approximately equal. Most preferably, the driver transistor 11a1 and programming transistor 11an have the same size (W and L). That is, it is preferable to satisfy the relationships Iw1=Iw2, Iw=2Ie. Of course the relationship Iw1=Iw2 can be satisfied not only by matching the transistor sizes (W and L), but also by varying the sizes. This can be achieved easily by adjusting WL of the transistor. If Iw2/Iw1 approximately equals 1, the sizes of the transistor 11b1 and transistor 11b1 can be roughly matched.

Preferably, Iw2/Iw1 is between 1 and 10 (both inclusive). Preferably, Iw2/Iw1 is between 1 and 10 (both inclusive). More preferably, it is between 1.5 and 5 (both inclusive).

If Iw2/Iw1 is 1 or less, little reduction can be expected in the effect of the parasitic capacitance of the source signal line 18. On the other hand, if Iw2/Iw1 is 10 or larger, there will be variations in the relationship of Ie to Iw among pixels, making it impossible to achieve uniform image display. Beside, the turn-on resistance of the transistor 11b will have an increased effect, making pixel design difficult.

If the current Iw2 passed by the programming transistor 11an is larger than the current Iw1 passed by the driver transistor 11a1 by a certain factor (Iw2>Iw1), the turn-on resistance of the switching transistor 11b2 should be lower than the turn-on resistance of the switching transistor 11b1. This is because the switching transistor 11b2 should be configured to pass a larger current than the switching transistor 11b1 at the same voltage of the gate signal line 17a.

That is, the size of the transistor 11b1 with respect to the magnitude of the output current of the driver transistor 11a1 should match the size of the transistor 11b2 with respect to the magnitude of the output current of the programming transistor 11an.

In other words, the turn-on resistance of the transistor 11b should be varied between the programming current Iw2 and the programming current Iw1. Also, the size of the transistors 11b1 and 11b2 should be varied between the programming current Iw2 and programming current Iw1.

If the programming current Iw2 is larger than the programming current Iw1, the turn-on resistance of the transistor 11b2 should be lower than the turn-on resistance of the transistor 11b1 (if the transistor 11b1 and transistor 11b2 are equal in gate terminal voltage) If the programming current Iw2 is larger than the programming current Iw1, the turn-on current (Iw2) of the transistor 11b2 should be larger than the turn-on current (Iw1) of the transistor 11b1 (if the transistor 11b1 and transistor 11b2 are equal in gate terminal voltage).

Suppose, Iw2:Iw1=n:1. Suppose also, the turn-on resistance of the transistor 11b2 is R2 and the turn-on resistance of the transistor 11b1 is R1 when the transistor 11b1 and transistor 11b2 are turned on by the application of a turn-on voltage to the gate signal line 17a. R2 should be between R1/(n+5) and R1/n (both inclusive), where n is a value larger than 1. This can be achieved by forming, placing, or operating the transistor 11b in such a way as to have a predetermined size.

The above items concern the turn-on resistance R of the transistor 11b1 and transistor 11b2 or the programming current Iw. Thus, any pixel configuration may be used as long as it satisfies the above conditions. For example, if gate terminals of the transistor 11b1 and transistor 11b2 are connected with different gate signal lines 17, the turn-on resistance and the like can be varied by applying different voltages to the different gate signal lines, and thus the conditions of the present invention can be satisfied.

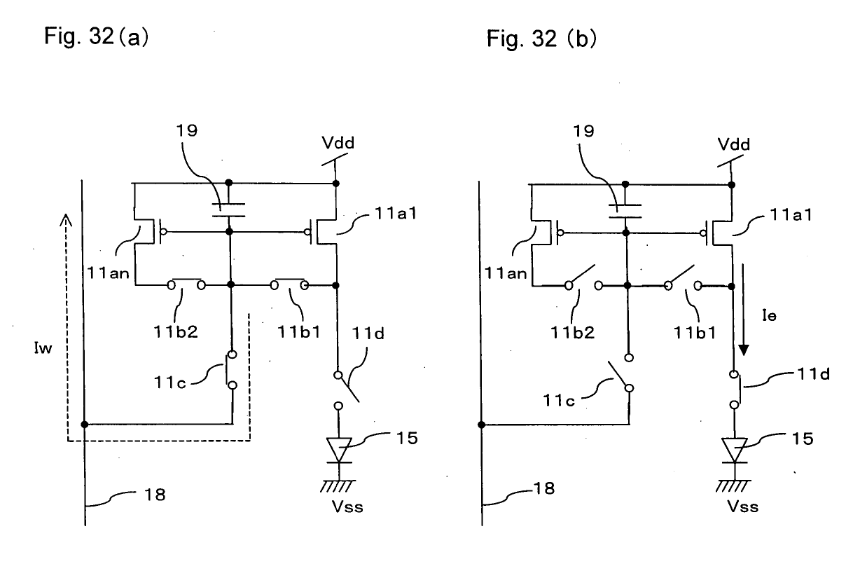

FIG. 32 is an explanatory diagram illustrating operation of the pixel shown in FIG. 31. FIG. 32(a) shows current programming mode and FIG. 31(b) shows a state in which current is being supplied to the EL element 15. Needless to say, in the state shown in FIG. 32(b), the transistor may be turned on and off to achieve intermittent display.

In FIG. 32(a), a turn-on voltage is applied to the gate signal line 17a to turn on the transistors 11b1, 11b2, and 11c. The current Ie is supplied by the transistor 11a1, current Iw−Ie is supplied by the transistor 11an, and resultant current Iw provides a programming current for the source driver IC. The above operations cause a current corresponding to the programming current Iw to be held in the capacitor 19. During current programming, the transistor 11d is kept off (a turn-off voltage is being applied to the gate signal line 17b).

FIG. 32(b) shows an operating state in which current is passed through the EL element 15. A turn-off voltage is applied to the gate signal line 17a and a turn-on voltage is applied to the gate signal line 17b. In this state, the transistors 11b1, 11b2, and 11c are off while the transistor 11d is on. The current Ie is supplied to the EL element 15.

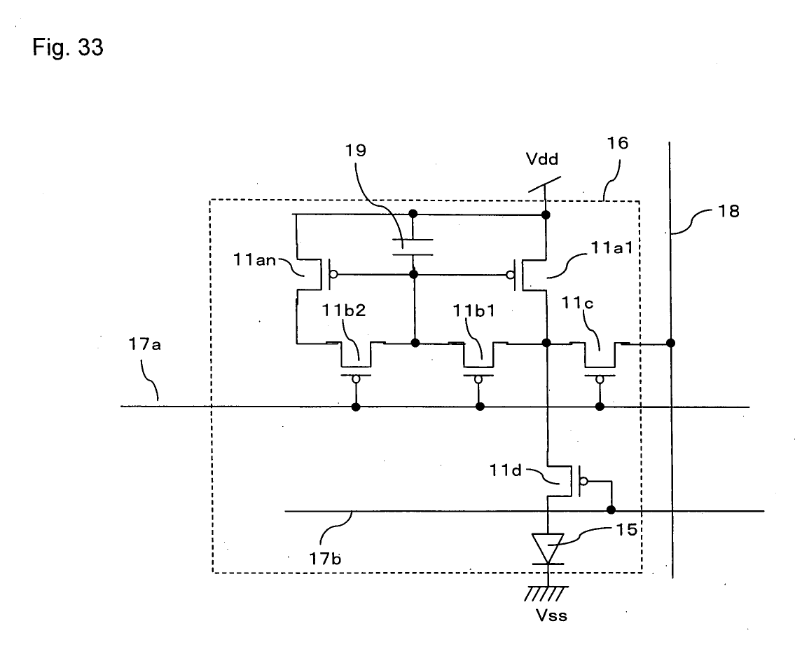

FIG. 33 is a variation of FIG. 31. In FIG. 33, the transistor 11c is placed between the source signal line 18 and drain terminal of the transistor 11a1. In this way, the configuration in FIG. 31 has many variations.

In FIG. 31, the transistors 11b1, 11b2 and 11c are controlled by applying the on-off voltage to the gate signal line 17a. However, when changing from current programming mode to voltage programming mode, the voltage held in the capacitor 19 may differ from a specified value when the transistors 11b1, 11b2, and 11c turn off simultaneously unlike when the transistor 11c turns off before the transistors 11b1 and 11b2. This will cause errors in the current Ie supplied from the driver transistor 11a to the EL element 15.

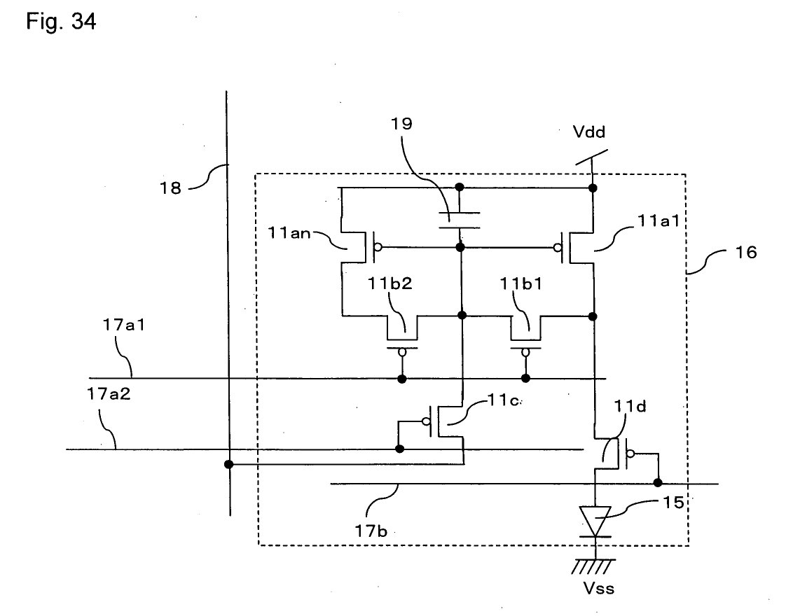

To deal with this problem, the configuration shown in FIG. 34 is preferable. In FIG. 34, the gate terminals of the transistor 11b1 and transistor 11b2 on the gate signal line 17a1 are connected. Besides, the gate signal line 17a2 is connected with the gate terminal of the transistor 11c. Therefore, the transistors 11b1 and 11b2 are on-off controlled by applying the on-off voltage to the gate signal line 17a1. Also, the transistor 11c is on-off controlled by applying the on-off voltage to the gate signal line 17a2.

When changing from current programming mode to a mode other than the current programming mode (when changing from a state in which a turn-on voltage is applied to the gate signal lines 17a1 and 17a2 to a state in which a turn-off voltage is applied to the gate signal lines 17a1 and 17a2), first the voltage applied to the gate signal line 17a1 is changed from turn-on voltage to turn-off voltage. Consequently, the transistors 11b1 and 11b2 are turned off. Then, the voltage applied to the gate signal line 17a2 is changed from turn-on voltage to turn-off voltage. Consequently, the transistor 11c is turned off.

By turning off the transistors 11b1 and 11b2 before turning off the transistor 11c as described above, it is possible to reduce the effect of penetration voltage as well as reduce the amount of leakage current and the like, causing a voltage of specified value to be held in the capacitor 19. Preferably, the time lag between the timing to apply a turn-off voltage to the gate signal line 17a1 and the timing to apply a turn-off voltage to the gate signal line 17a2 is between 0.1 and 5 μsec (both inclusive).

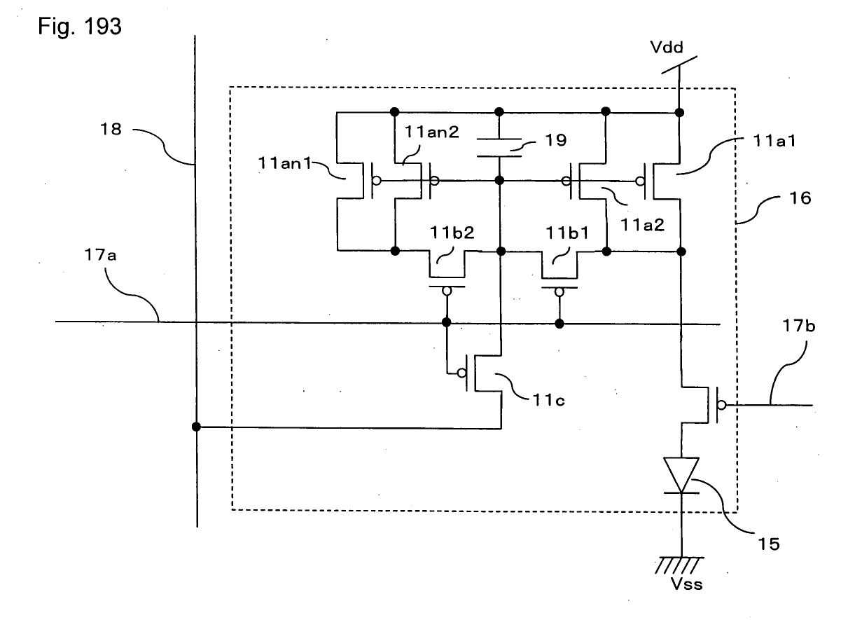

Although only one driver transistor 11a is shown in FIG. 34, the present invention is not limited to this. There may be two or more driver transistors 11a as illustrated in FIG. 193, in which there are two transistors 11a (driver transistors 11a1 and 11a2) that drive the EL element 15 and two programming transistors 11an (11an1 and 11an2). The configuration in FIG. 193 makes it possible to reduce variations in pixel characteristics. Incidentally, the driver transistors 11a and programming transistors 11an may be arranged alternately.

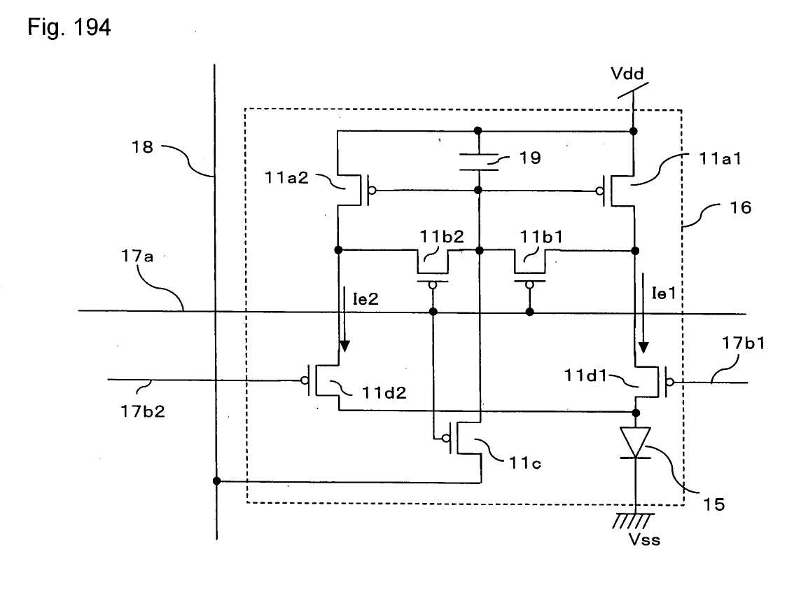

The pixel configuration in FIG. 194 is also useful. It contains two driver transistors 11a (11a1 and 11a2), both of which supply the current Ie to the EL element 15 to make the EL element 15 emit light at brightness B.

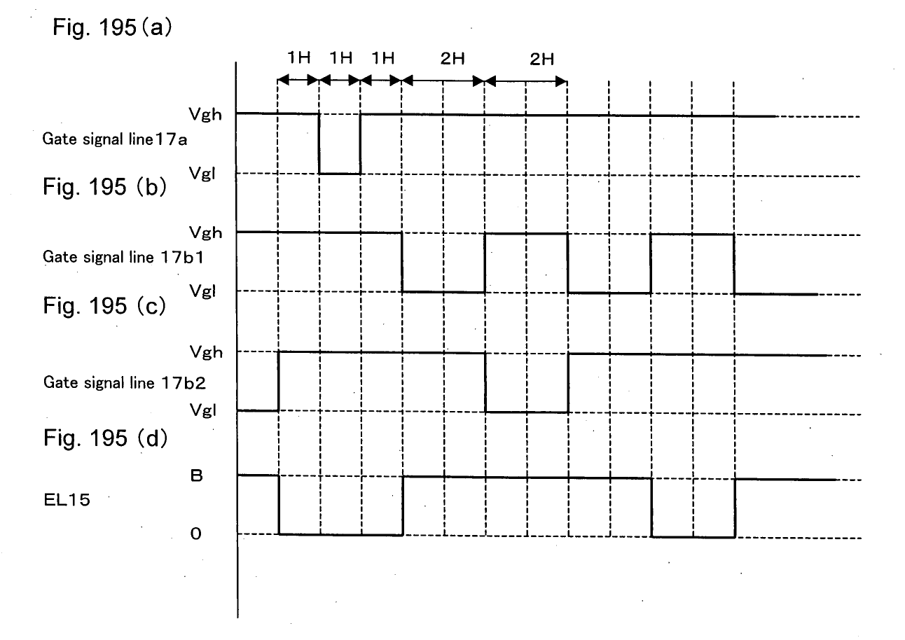

FIG. 195 is a timing chart illustrating operation of the pixel shown in FIG. 194. The operation of the pixel shown in FIG. 194 will be described below. Pixels such as the one shown in FIG. 194 are arranged in a matrix and are selected in sequence as respective gate signal lines are selected. For ease of explanation, only a single pixel will be described here as in the case of FIG. 1.

First, as the gate signal line 17a is selected and a Vgl voltage is applied to it, the transistors 11b2, 11b1, and 11c are turned on and triggered into conduction. In this state, the programming current applied to the source signal line 18 flows to the transistors 11a2 and 11a1 and voltage is held in the capacitor 19 so as to allow the programming current Iw to flow (see the line chart of the gate signal line 17a in FIG. 195). This completes current programming. A turn-on voltage (Vgl) is applied to the gate signal line 17a for a period of 1 H, and then a turn-off voltage (Vgh) is applied after a selection period. The above are basic operations. Needless to say, actually the on/off timing of the gate signal line and the like follow the charts shown in FIGS. 26, 27, etc.

Then, the gate signal line 17b1 is selected (Vgl voltage is applied) during the period in which the current Ie1 from the driver transistor 11a1 is passed through the EL element 15. On the other hand, a turn-off voltage (Vgh voltage) is applied to the gate signal line 17b1 during the period in which current is not passed through the EL element 15. As the above states are repeated regularly, periodically, or randomly, the EL element 15 emits light. In FIG. 195, the EL element 15 emits light at brightness B. Incidentally, a timing chart of the gate signal line 17b1 is shown in FIG. 195.

The gate signal line 17b2 is selected (Vgl voltage is applied) during the period in which the current Ie2 from the driver transistor 11a2 is passed through the EL element 15. On the other hand, a turn-off voltage (Vgh voltage) is applied to the gate signal line 17b2 during the period in which current is not passed through the EL element 15. As the above states are repeated regularly, periodically, or randomly, the EL element 15 emits light (in FIG. 195, the EL element 15 emits light at brightness B. Incidentally, a timing chart of the gate signal line 17b2 is shown in FIG. 195.

Although in the example in FIGS. 194 and 195, two driver transistors 11a are used by switching between them, this is not restrictive. It is alternatively possible to form or place three or more driver transistors 11a and supply the current Ie to the EL element 15 by switching among them. Also, two or more driver transistors 11a may supply the current Ie to the EL element 15 simultaneously. The current Ie1 supplied to the EL element 15 by the driver transistor 11a1 may differ in magnitude from the current Ie2 supplied to the EL element 15 by the driver transistor 11a2.

The plurality of driver transistors 11a may be different in size. Also, the time periods during which the plurality of driver transistors 11a pass current through the EL element 15 do not have to be equal and may vary. For example, the driver transistor 11a1 may supply current to the EL element 15 for 10 μsec and the driver transistor 11a2 may supply current to the EL element 15 for 20 μsec.

Although in FIG. 194, the gate terminals of the driver transistors 11a1 and 11a2 share a connection, this is not restrictive. Needless to say, different gate terminals may be set to different potentials. The above example is also applicable to the pixel configurations in FIGS. 31 to 36. In that case, it is applied to the programming transistors and driver transistors.

The example described above is mainly a variation of the pixel configuration in FIG. 1. However, the present invention is not limited to this and is applicable to the current-mirror pixel configuration in FIG. 13 and the like.

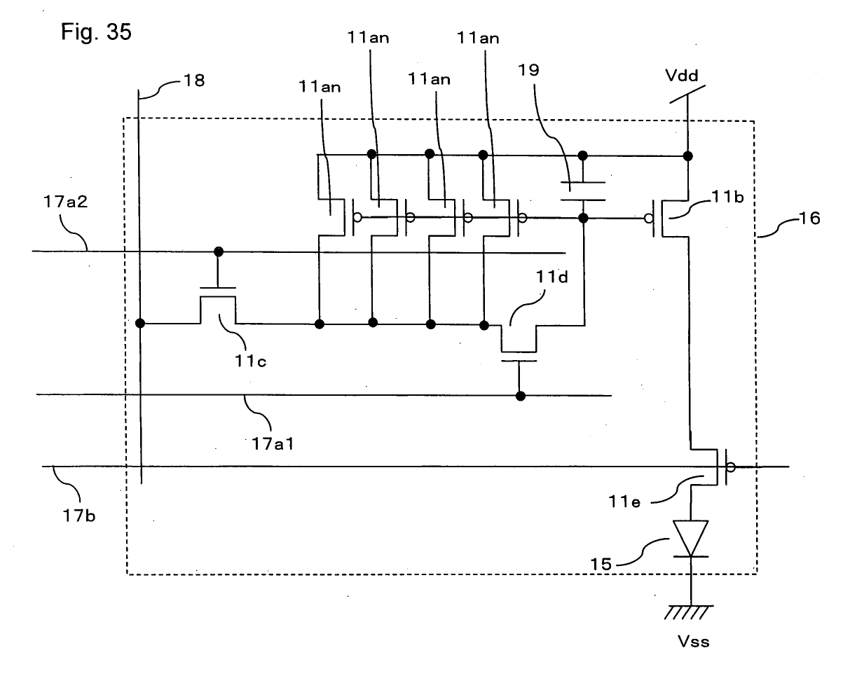

FIG. 35 is an example of the present invention. It contains one driver transistor 11b and four programming transistors 11an. The rest of the configuration is the same as the example in FIG. 12 or 13.

In the example in FIG. 35, when the gate signal lines 17a1 and 17a2 are selected, the transistors 11c and 11d turn on, forming a current path between the programming transistors 11an and the source signal line 18. Preferably the four programming transistors 11an have the same size (the same channel width W and same channel length L). However, the present invention may configure a pixel with a single programming transistor 11an. In that case, it is preferable to achieve a predetermined programming current Iw by taking into consideration the shape or WL ratio of the single programming transistor 11an.

According to the example in FIG. 35, the programming current Iw is a combination of currents from the four programming transistors 11an. For ease of explanation, it is assumed that equal currents flow through the four programming transistors 11a. For ease of explanation, the transistor 11a which supplies current Ie to the EL element is referred to as a driver transistor 11b and the transistors 11an which operate during current programming are referred to as programming transistors 11an.

In FIG. 35, the driver transistor 11b and one programming transistor 11an pass equal currents (provided that equal voltages are applied to the gate terminals of the driver transistor and the programming transistor). To produce equal output currents, the transistors 11an and 11b can have the same WL (channel width W and channel length L). The use of a plurality of the transistors 11a of the same WL or with the same WL ratio is preferable because it reduces output variations among the transistors 11a, thereby reducing variations among the pixels 16.

When a selection voltage (turn-on voltage) is applied to the gate signal lines 17a1, 17a2, currents from a plurality of the programming transistors 11an are combined into a programming current Iw. The programming current Iw bears a predetermined ratio to the current Ie flowing from the driver transistor 11b to the EL element 15.

Iw=n*Ie (n is a natural number excluding 0) In the above equation, if B (nt) is the display brightness of maximum white raster on the display panel, S (square millimeters) is the pixel area on the display panel (R, G, and B are treated as a unit. Thus, if each of RGB picture elements measures 0.1 mm (L) and 0.05 (W), then S=0.1×(0.05×3) square millimeters), and H (milliseconds) is one pixel selection period (one horizontal scanning (1H) period), the following condition should be satisfied. The display brightness B is the maximum displayable brightness prescribed by panel specification.
5≦(B*S)/(n*H)≦150

More preferably, the following condition should be satisfied.
10≦(B*S)/(n*H)≦100

Iw is the programming current outputted by the source driver circuit (IC) 14. The voltage corresponding to this programming current is held by the capacitor 19 of the pixel 16. On the other hand, Ie is the current passed through the EL element 15 by the driver transistor 11a.

Thus, the WL or size (transistor shape) of the driver transistor 11b and programming transistors 11an are formed or configured in such a way as to satisfy the above equations. For ease of explanation, it is assumed in the configuration in FIG. 35 that the size or supply current of the driver transistor 11b is equal to the size (shape) or supply current of each programming transistor 11a. Then, the above equation can be satisfied using n−1 programming transistors 11a. The pixel configuration in FIG. 35, in particular, can also use the current of the driver transistor 11a as a programming current, and thereby make the aperture ratio of the pixel 16 larger than possible with current-mirror pixel configurations.

When the pixel 16 is configured as described above, the programming current Iw becomes n times larger than Ie. Thus, even if there is parasitic capacitance in the source signal line 18, insufficient writing can be avoided.

Variations in the output of the transistor 11b and transistors 11an can be reduced by forming or placing the programming transistors 11an and driver transistor 11b close to each other. Also, the characteristics of the transistors 11an and transistor 11b may vary with their formation direction. Thus, preferably the channels of the transistors are formed in the same direction, either laterally or longitudinally.

In EL display panels, R, G, and B EL elements are made of different material. Thus, luminous efficiency often varies from color to color. Consequently, the programming current Iw also varies among R, G, and B. However, parasitic capacitance of the source signal line 18 generally does not vary among R, G, and B and is often identical among them. Since the programming current Iw varies among R, G, and B and parasitic capacitance of the source signal line is identical among R, G, and B, the write time constant of the programming current varies.

With the pixel configuration in FIG. 35, the number of programming transistors 11an can be varied among R, G, and B. Needless to say, the size (WL, etc.) or supply current of the programming transistors 11an can be varied among R, G, and B as well. Also, the number or size of driver transistors 11b may be varied.

The above is applied to the pixel configuration shown in FIGS. 31, 33, 34 or the like. The number of programming transistors 11an can be varied among R, G, and B. Needless to say, the size (WL, etc.) or supply current of the programming transistors 11an can be varied among R, G, and B as well. Also, the number or size of driver transistors 11b may be varied.

FIG. 574 shows an example in which five driver transistors 11a are formed. The rest of the configuration is the same as in the example in FIG. 1. In the example in FIG. 1, the programming current Iw equals the current flowing through the EL element 15. Thus, to make the EL element 15 emit light at a low brightness, the programming current Iw is decreased, rendering the source signal line 18 susceptible to parasitic capacitance (it takes time to charge and discharge parasitic capacitance during a 1H period, making it difficult to set the gate terminal of the driver transistor 11a to a predetermined potential).

In the example in FIG. 574, when the gate signal line 17a is selected, the transistors 11e, 11b, and 11c turn on, forming a current path between the driver transistor 11a and the source signal line 18. The programming current Iw is a combination of currents from the driver transistors 11a, 11a2, 11a3, 11a4, and 11a5. For ease of explanation, it is assumed that equal currents flow through the driver transistors 11a. For ease of explanation, the transistor 11a which supplies current Ie to the EL element is referred to as a driver transistor and the transistor 11a2 and the like which operate during current programming are referred to as programming transistors 11a.

In FIG. 574, the driver transistor 11a and each programming transistor 11a pass equal currents (provided that equal voltages are applied to the gate terminals) To produce equal output currents, the transistors 11a can have the same WL (channel width W and channel length L). The use of multiple transistors 11a of the same WL is preferable because it reduces output variations among the transistors 11a, thereby reducing variations among the pixels 16. For the same reason, the source driver IC 14 described later with reference to FIG. 5 is composed of a plurality of unit transistors 153.

However, the present invention is not limited to this. A single programming transistor 11a may be used instead of the plurality of programming transistors 11a. In that case, the single programming transistor 11a can be configured easily by increasing its W.

When a selection voltage (turn-on voltage) is applied to the gate signal line 17a, the current from the drive transistor 11a and current from the programming transistor 11a are combined into a programming current Iw. The programming current Iw bears a predetermined ratio to the current Ie to the EL element 15.

Iw=n*Ie (n is a natural number excluding 0)

In the above equation, if B (nt) is the display brightness of maximum white raster on the display panel, S (square millimeters) is the pixel area on the display panel (R, G, and B are treated as a unit. Thus, if each of RGB picture elements measures 0.1 mm (L) and 0.05 (W), then S=0.1×(0.05×3) square millimeters), and H (milliseconds) is one pixel selection period (one horizontal scanning (1H) period), the following condition should be satisfied. The display brightness B is the maximum displayable brightness prescribed by panel specification.
5≦(B*S)/(n*H)≦150
More preferably, the following condition should be satisfied.
10≦(B*S)/(n*H)≦100

Iw is the programming current outputted by the source driver circuit (IC) 14. The voltage corresponding to this programming current is held by the capacitor 19 of the pixel 16. On the other hand, Ie is the current passed through the EL element 15 by the driver transistor 11a1. Errors by the penetration voltage or the like are not considered here.

Thus, the WL, size and the output current of the programming transistor 11a is formed or configured in such a way as to satisfy the above equations. It is assumed in the configuration in FIG. 574 that the size or supply current of the driver transistor 11a is equal to the size (shape) or supply current of each programming transistor 11a. Then, the above equation can be satisfied using n−1 programming transistors 11a. The pixel configuration in FIG. 574, in particular, can also use the current of the driver transistor 11a as a programming current, and thereby make the aperture ratio of the pixel 16 larger than possible with current-mirror pixel configurations.

When the pixel 16 is configured as described above, the programming current Iw becomes n times larger than Ie. Thus, even if there is parasitic capacitance in the source signal line 18, insufficient writing can be avoided.

In FIG. 1, the programming current Iw is equal to the current Ie flowing through the EL element 15. This eliminates variations. However, in the configuration in FIG. 574, part of the programming current Iw becomes a current Ie flowing through the EL element 15. This contains possibilities for variations.

To prevent this problem, the programming transistors 11a and driver transistor 11a are formed or placed in close proximity to each other (see FIG. 575). In FIG. 575, the programming transistors 11a and driver transistor 11a have the same WL. The driver transistor 11a is flanked on both sides by programming transistors 11a. This configuration makes it possible to reduce variations in the transistors 11a and maintain the relationship Iw=n*Ie accurately.

Although there is one driver transistor 11a in the example in FIG. 574, the present invention is not limited to this. There may be two or more driver transistors 11a (11aa and 11ab) as illustrated in FIG. 576. Also, the transistors 11 maybe formed in different directions as illustrated in FIG. 577.

The characteristics of the transistors 11a may vary with their formation direction. Thus, as shown in FIG. 575, the output variations can be reduced by forming one driver transistor 11aa laterally and the other driver transistors 11ab longitudinally. As shown in FIG. 575, the programming transistors 11a are also preferably placed in the same direction, either laterally or longitudinally.

In EL display panels, R, G, and B EL elements are made of different material. Thus, luminous efficiency often varies from color to color. Consequently, the programming current Iw also varies among R, G, and B. However, parasitic capacitance of the source signal line 18 generally does not vary among R, G, and B and is often identical among them. Since the programming current Iw varies among R, G, and B and parasitic capacitance of the source signal line is identical among R, G, and B, the write time constant of the programming current varies.

To the above problem, the present invention varies the number of programming transistors 11a among R, G, and B. One example is that there may be two programming transistors 11a of R pixel 16 and four programming transistors 11a of G pixel 16, and one programming transistor 11a of B pixel 16.

Although the number of programming transistors 11an is varied among R, G, and B in the example in FIG. 578, the present invention is not limited to this. Needless to say, for example, the size (W, L, etc.) or supply current of the programming transistors 11an may be varied among R, G, and B. Also, it goes without saying that the same number of programming transistors 11an may be used for R, G, and B if the programming currents for R, G, and B are equal or approximately equal to each other.

Although the number of programming transistors 11an is varied among R, G, and B in the example in FIG. 578, the present invention is not limited to this. For example, the number or size of driver transistors 11a may be varied as illustrated in FIG. 579.

In FIG. 579, the transistors are formed or configured such that the size of the driver transistor 11a for the B pixel>the size of the driver transistor 11a for the G pixel>the size of the driver transistor 11a for the R pixel.

In the example in FIG. 574, etc., the current Ie from the driver transistor 11a is outputted to the source signal line 18 via the transistors 11e and 11c during current programming. The output current Iw−Ie is outputted to the source signal line 18 via only a single transistor 11c. On the transistors 11e and 11c, a potential difference appears between the source and drain even when they are on. This may make the output current of the driver transistor 11a smaller than the output current of each programming transistor 11a.

To deal with this problem, preferably, it is preferable to use a configuration such as the one shown in FIG. 580. In the configuration in FIG. 580, the current Ie from the driver transistor 11a1 is outputted to the source signal line 18 via the transistor 11c1. On the other hand, the output current Iw−Ie from the programming transistor 11an is outputted to the source signal line 18 via the transistor 11c2. Thus, the current from the driver transistor 11a1 and current from the programming transistor 11an pass the same number of transistors before they reach the source signal line 18. This eliminates the effect of the potential difference between the source and drain of the transistors, making the output current of the driver transistor 11a1 equal to the output current of each programming transistor 11an.

In FIG. 580, a transistor 11b1 is formed or placed to short-circuit the gate and drain of the driver transistor 11a. Similarly, a transistor 11b2 is formed or placed to short-circuit the gate and drain of the programming transistor 11an.

FIG. 581 is a diagram of pixel configuration in which a transistor 11b1 is formed to connect the drain terminals of the programming transistor 11a1 and programming transistor 11an. However, in the pixel configuration in FIG. 581, the pixel 16 contains as many as seven transistors, reducing the pixel aperture ratio.

FIG. 323 shows an example in which the pixel 16 contains six transistors, the programming transistor 11an is connected to the source signal line 18 via two transistors 11an and 11b2, and the driver transistor 11a1 is connected to the source signal line 18 via two transistors 11b1 and 11c.

By making the currents from the driver transistor 11a1 and programming transistor 11an to pass the same number of transistors in this way, it is possible to increase accuracy.

In FIG. 35, the transistor 11c is controlled by the gate signal line 17a2 and the transistor 11d is controlled by the gate signal line 17a1. This prevents the transistors 11c and 11d from turning off simultaneously when switching from current programming mode to another mode.

When switching from current programming mode to another mode (when applying a turn-off voltage to the gate signal lines 17a1 and 17a2 by stopping to apply a turn-on voltage), first the voltage applied to the gate signal line 17a2 is changed from turn-on voltage to turn-off voltage. Consequently, the transistor 11d is turned off. Then, the voltage applied to the gate signal line 17a1 is changed from turn-on voltage to turn-off voltage. This turns off the transistor 11c.

By turning off the transistor 11d before turning off the transistor 11c as described above, it is possible to reduce the effect of penetration voltage. Also, the amount of leakage current is reduced, and thus a voltage of specified value is held in the capacitor 19. Preferably, the time lag between the timing to apply a turn-off voltage to the gate signal line 17a1 and the timing to apply a turn-off voltage to the gate signal line 17a2 is between 0.1 and 5 μsec (both inclusive).

There is a method which achieves a proper black display by shifting the gate potential of the driver transistor 11a. Generally it is difficult to achieve black display especially in the case of current driving. FIG. 375 shows a configuration in which the potential is shifted via the capacitor 19 connected to the gate terminal of the driver transistor 11a.

In the following example, it is assumed that the driver transistor 11a is a P-channel transistor. However, the present invention is not limited to this. Needless to say, the direction of the potential shift must be reversed if the driver transistor 11a (transistor which drives the EL element 15) is an N-channel transistor or if the driver transistor 11a is programmed with a discharge current. That is, the wording of phrases herein should be changed as appropriate. The change of wording is easy for those skilled in the art, and thus description thereof will be omitted. Incidentally, this also applies to other examples of the present invention.

In FIG. 375, an end of the capacitor 19 is connected to a capacitor signal line 3751. The capacitor signal line 3751 is driven by a capacitor driver 3752. The capacitor driver 3752 is formed by polysilicon technology. It operates in the same manner as, or in a manner similar to, the gate driver circuit 12. However, the capacitor driver 3752 differs from the gate driver circuit 12 in amplitude because it shifts the potential at the gate terminal of the driver transistor 11a within a range of 0.1 to 1 V.

While a programming current is written into the pixel 16, the potential of the capacitor signal line 3751 is kept constant. When the programming current has been written into the pixel 16 (when a write period of 1 H is over), the potential of the capacitor signal line 3751 is shifted toward the anode voltage Vdd by the capacitor driver 3752. This potential shift causes the potential at the gate terminal of the driver transistor 11a to be shifted toward the anode voltage Vdd as well. That is, the potential at the gate terminal of the driver transistor 11a is shifted toward the side where no current flows.

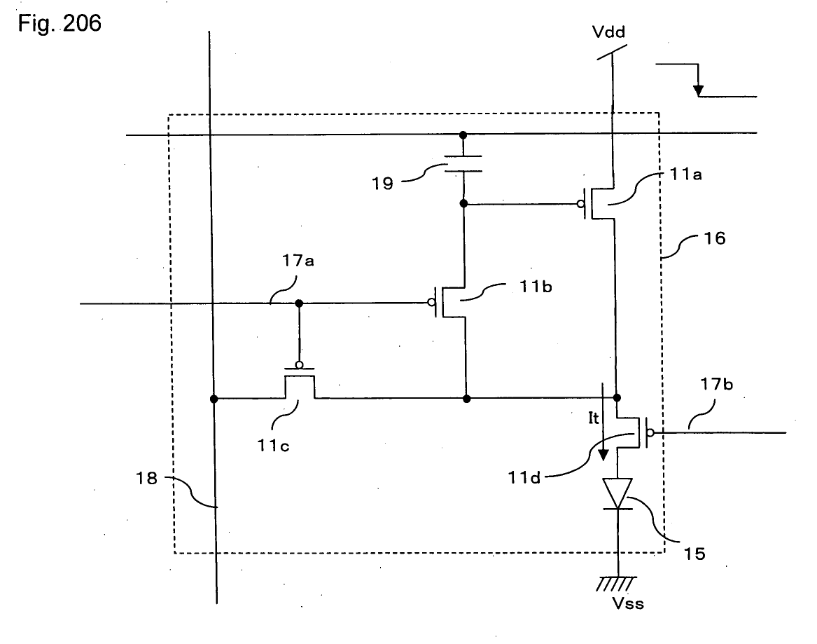

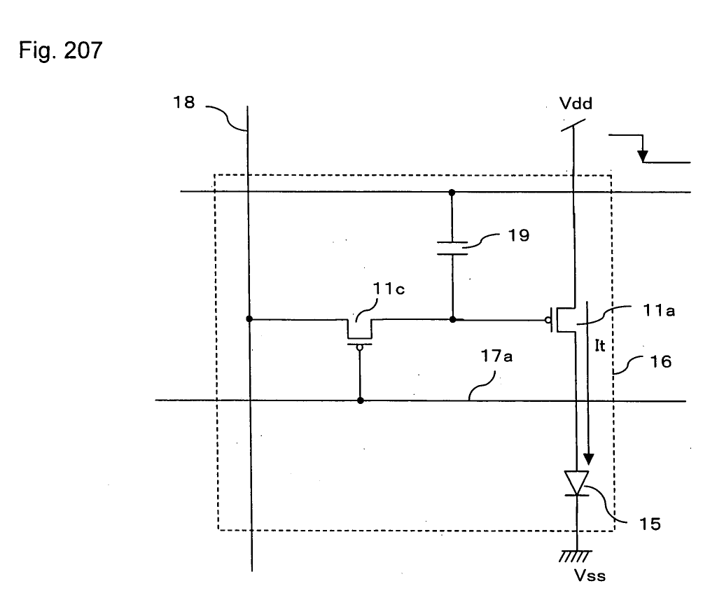

The above operations make it hard for the driver transistor 11a to pass current in a low gradation region on the display apparatus (display panel) according to the present invention. This makes it possible to achieve a proper black display. FIG. 375(a) is an example in which the drive method according to the present invention is applied to the pixel configuration in FIG. 1. FIG. 375(b) shows an example in which the drive method is applied mainly to the current-mirror pixel configuration in FIG. 12 and the like. FIG. 207 shows an example in which the drive method is applied to a double-transistor pixel configuration. The pixel configuration in FIG. 206 also achieves a proper image display by manipulating the potential at one electrode of the capacitor 19.

In FIG. 375, the potential of the capacitor signal line 3751 is shifted by the capacitor driver 3752. However, the present invention is not limited to this. The potential of the capacitor signal line 3751 may be set equal to or higher than the anode potential Vdd to achieve a proper black display. This is because the larger the potential of the capacitor signal line 3751, the larger the difference from the turn-on voltage Vgl1 of the gate signal line 17a, causing parasitic capacitance of the transistor 11b and penetration voltage of the capacitor 19 to increase the potential shift at the gate terminal of the transistor 11a.

For example, the capacitor signal line 3751 produces a larger penetration voltage at a potential of 10 V than at a potential of 6 V, increasing the potential shift at the gate terminal of the transistor 11a and making it hard for the driver transistor 11a to pass current in a low gradation region. This makes it possible to achieve a proper black display.

In a current-driven pixel configuration, the present invention allows voltages to be applied separately (different voltages to be applied) to the source terminal (an anode terminal Vdd) of the driver transistor 11a and the terminal of the capacitor 19, which holds the gate terminal potential of the driver transistor 11a. (It is assumed that the driver transistor 11a is a P-channel transistor and that current programming is performed with sink current. Needless to say, the relationship is reversed if the driver transistor 11a is an N-channel transistor.) This configuration makes it possible to adjust or control black display by varying the potential at one terminal of the capacitor 19. Incidentally, the adjustment or control are performed based on relative relationships between the terminal voltage of the capacitor 19 and voltage at the source or drain terminal of the driver transistor 11a. Thus, needless to say, it is also possible to vary the anode potential with the potential at one terminal of the capacitor 19 fixed.

Incidentally, the above example improves black display by manipulating the capacitor signal line 3751. However, the present invention is not limited to this. For example, if the driver transistor 11a is an N-channel transistor, the present invention can increase current in a high gradation region by manipulating the capacitor signal line 3751 and the like. Thus, it can achieve proper white display.

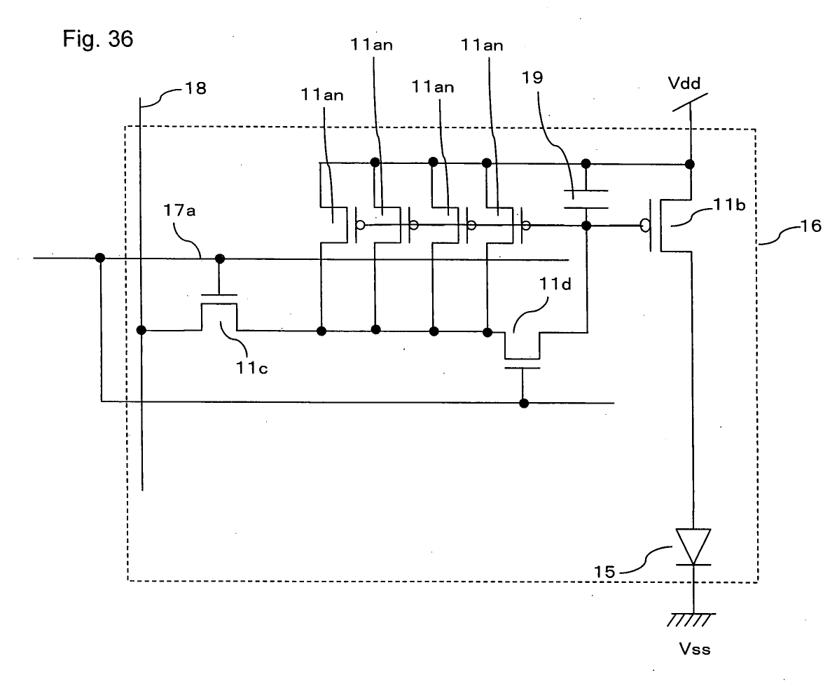

FIG. 36 shows a configuration which allows the transistor 11c and transistor 11d to be controlled by voltages applied to the gate signal line 17a. This configuration reduces the number of signal lines because the pixel 16 can be driven by a single gate signal line 17. It cannot produce a non-display area 192, but it can control pixels easily and improve the pixel aperture ratio.

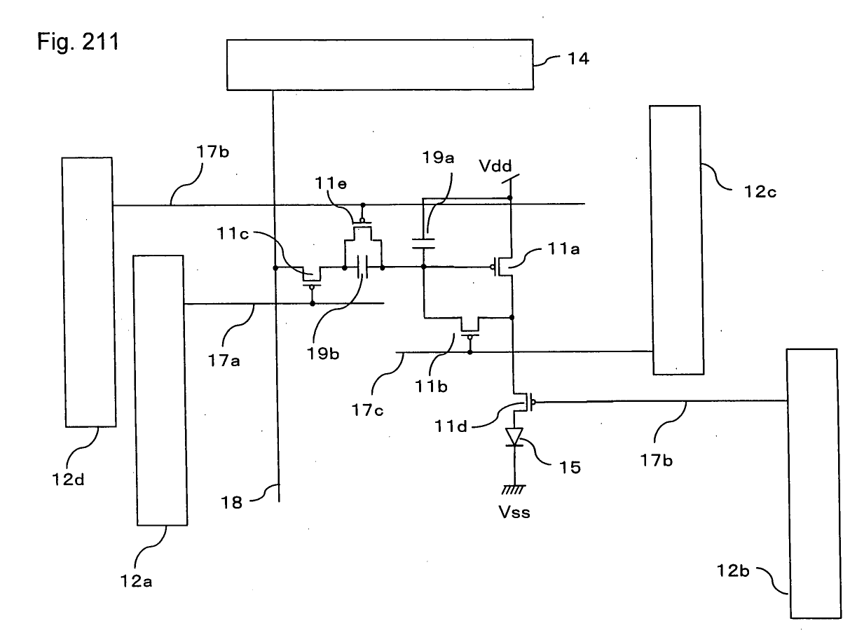

The above example concerns a current-driven pixel configuration. However, the present invention is not limited to this and can use a combination of voltage-driven and current-driven pixel configurations. The pixel configuration in FIG. 211 can perform both voltage driving and current driving.

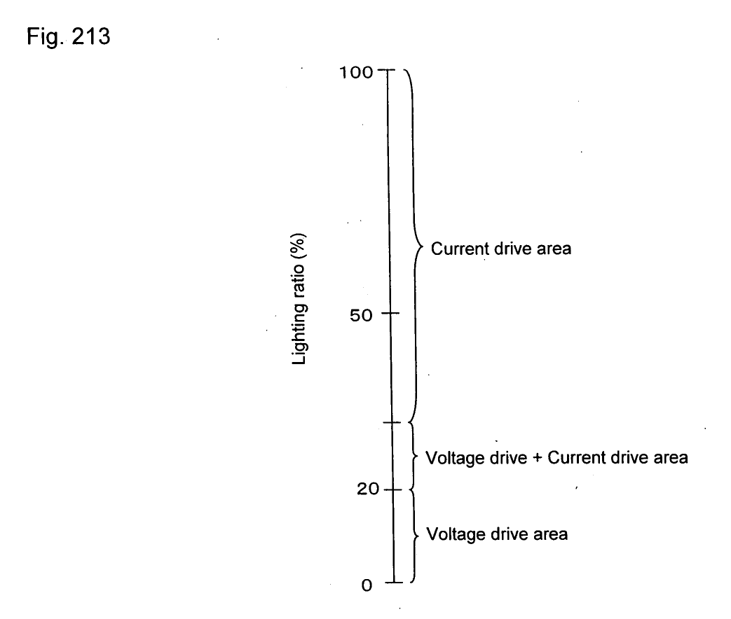

Current driving involves writing current in a low gradation region. On the other hand, voltage driving does not cause insufficient writing even in a low gradation region. However, with voltage driving, it is impossible to absorb variations in the characteristics of the driver transistors 11a appearing on the display screen, which thus displays irregularities produced in the annealing process due to variations in the characteristics of transistors. Current driving is free from the problem of variations in the characteristics of transistors. FIG. 213 is an explanatory diagram illustrating a drive method according to the present invention. As illustrated in FIG. 213, voltage driving is used in a low gradation region. Current driving is used in a high gradation region. In an intermediate gradation region, voltage driving and current driving are used in sequence. That is, the drive method according to the present invention uses both or one of current driving and voltage driving depending on gradations, and thereby solves the problems with current driving and voltage driving.

FIG. 211 shows a pixel configuration which can perform both voltage driving and current driving. For ease of explanation, it shows only a single pixel as in the case of FIG. 1. It also shows a driver circuit 12 and the like conceptually.

If the transistor lie is removed, FIG. 211 provides a pixel configuration for voltage offset canceling mode. Basically, shown in FIG. 211 is a pixel configuration for voltage offset canceling mode with the transistor 11e formed to short-circuit a capacitor 19b.

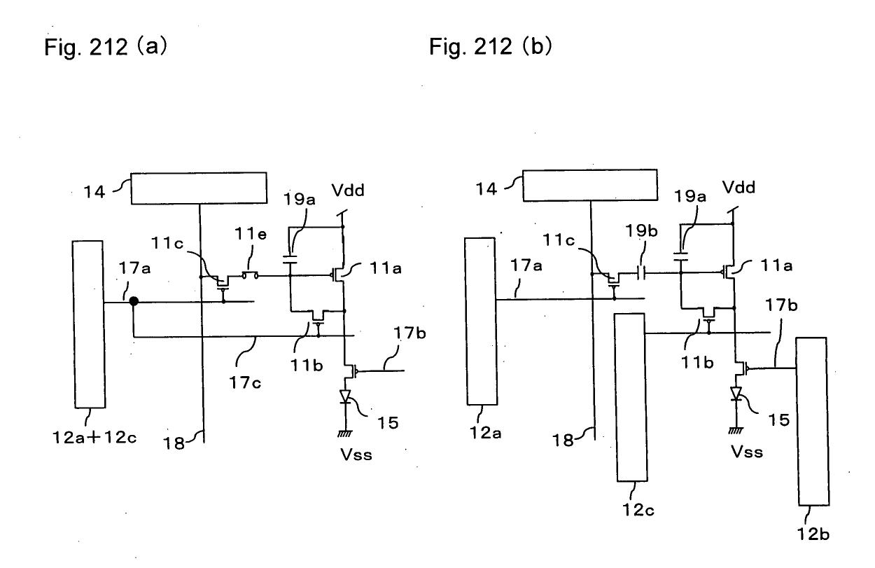

FIG. 212 is an explanatory diagram illustrating the pixel configuration in FIG. 211. FIG. 212(a) shows a state of a pixel during programming in current driving mode while FIG. 212(b) shows a state of a pixel during programming in voltage driving mode.

First, the current programming in FIG. 212(a) will be described. In FIG. 212(a), the transistor 11e is turned on. Consequently, the capacitor 19b is short-circuited at both ends. Gate driver circuits 12d and 12a operate in the same manner. In FIG. 212(a), they are indicated as 12a+12d.

To select each pixel row, the gate driver circuits 12a+12d applies a turn-on voltage to the gate signal lines 17b and 17a. Consequently, the transistors 11e, 11c, and 11b turn on simultaneously. That is, the pixel configuration in FIG. 212(a) is the same as that in FIG. 1. Thus, the programming current Iw outputted from the source driver circuit (IC) 14 is written into the driver transistor 11a.

Subsequent operations (selection/deselection and operation of the gate signal line 17b) are the same as those in FIG. 1, and thus description thereof will be omitted. Needless to say, all the drive methods described herein and applicable to FIG. 1 are also applicable to FIG. 212(a).

In FIG. 212(b), the gate signal line 17a and gate signal line 17b operate separately. Incidentally, this pixel configuration is known as a voltage offset canceller, and thus description of its operation will be omitted.

As illustrated in FIG. 213, the present invention uses the pixel circuit configuration shown in FIG. 212(b) in a low gradation region, and the pixel circuit configuration circuit shown in FIG. 212(a) in a high gradation region.

In a region intermediate between the high gradation region and low gradation region, it is preferable to use the circuit configuration shown in FIG. 212(b) at the beginning of 1 H and subsequently use the circuit configuration shown in FIG. 212(a). How to switch between the configurations in FIG. 212(a) and FIG. 212(b) should be determined by evaluation. Results of study indicate that it is preferable to use the voltage driving shown in FIG. 212(b) between the lowest gradation (gradation 0) and 1/10 to ¼ the entire range of gradations, and the current programming shown in FIG. 212(a) between ⅙ to ⅓ the entire range of gradations and the highest gradation.

The voltage driving shown in FIG. 212(b) and then current programming shown in FIG. 212(a) are performed except in the gradation ranges in which only current driving or voltage driving are performed. The voltage driving shown in FIG. 212(b) and then current programming shown in FIG. 212(a) may be performed in the high gradation region as well.

The voltage driving shown in FIG. 212(b) and then current programming shown in FIG. 212(a) may be performed in the low gradation region as well. This is because voltage programming mode is predominant in the low gradation region and current programming does not affect programming of the pixels 16 even if the current programming is performed after the voltage programming.

Thus, according to the present invention, at least voltage programming is performed in the low gradation region at the beginning of 1 H by setting up a configuration for voltage programming and at least current programming is performed in the high gradation region at the end of 1 H by setting up a configuration for current programming.

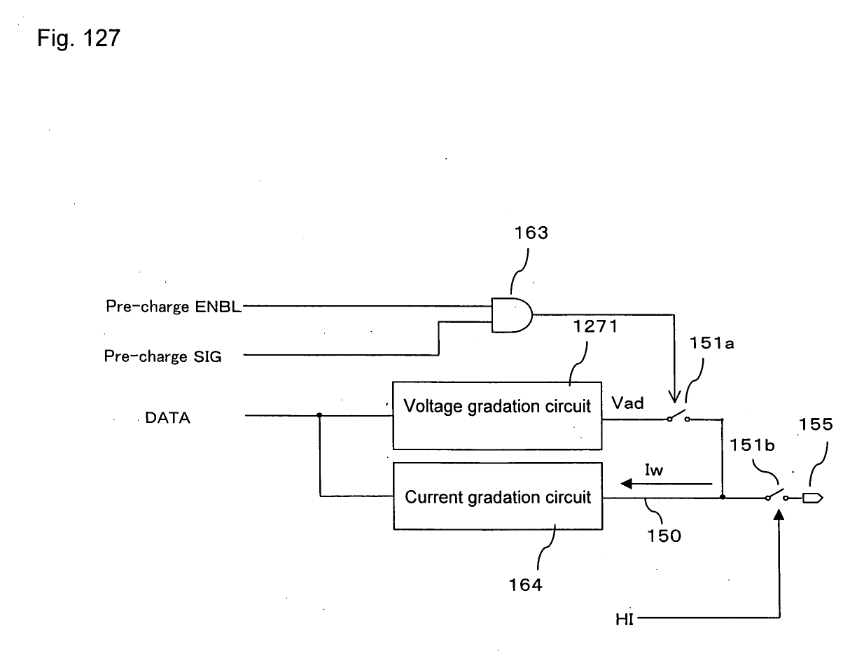

Since programming of the pixels 16 by a combination of current programming and voltage programming has bee described with reference to FIGS. 127 to 143, description thereof will be omitted. Needless to say, the drive method in FIGS. 211 and 212 and the drive method in FIGS. 127 to 143 may be combined.

FIG. 1 shows the pixel configuration of current programming. This is not limited to FIG. 1 however. The following method is applied to also in FIGS. 6, 7, 8, 9, 10, 11, 12, 13, 31, 607(a) (b) (c), or the like. Needless to say, the above is also applied to the other examples of the present invention in the same way.

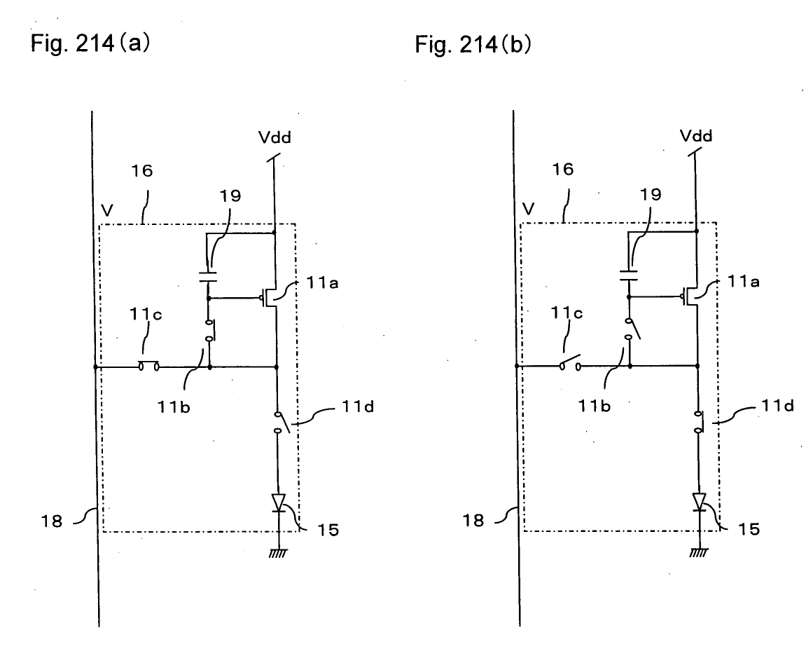

FIG. 214 shows an example in which voltage programming is performed using a current-driven pixel configuration. FIG. 214(a) shows a state in which voltage programming is performed. FIG. 214(b) shows a state in which a programming current Iw is passed through an EL element 15 to make it emit light.

In FIG. 214(a), a turn-on voltage is applied to the gate signal line 17a to turn on the transistors 11b and 11c. In this state, a programming voltage V is applied to the source signal line 18 and the voltage V is held by the capacitor 19 of the pixel 16. At this time, a turn-off voltage is applied to the gate signal line 17b to turn off (open) the transistor 17d.

FIG. 214(b) shows a state of transistors when the EL element 15 is made to emit light. A turn-off voltage is applied to the gate signal line 17a to open the transistors 11b and 11c. A turn-on voltage is applied to the gate signal line 17b to short-circuit (turn on) the transistor 11d.

Voltage programming is performed by driving the pixel in this way. That is, the programming voltage V is applied to the source signal line in the low gradation region at least at the beginning of 1 H and the programming current Iw is applied in the high gradation region at least at the end of 1 H.

The timing to switch between voltage driving and current driving has been described with reference to FIG. 212, FIGS. 127 to 143, etc., and thus description thereof will be omitted. The above items also apply to other examples of the present invention.

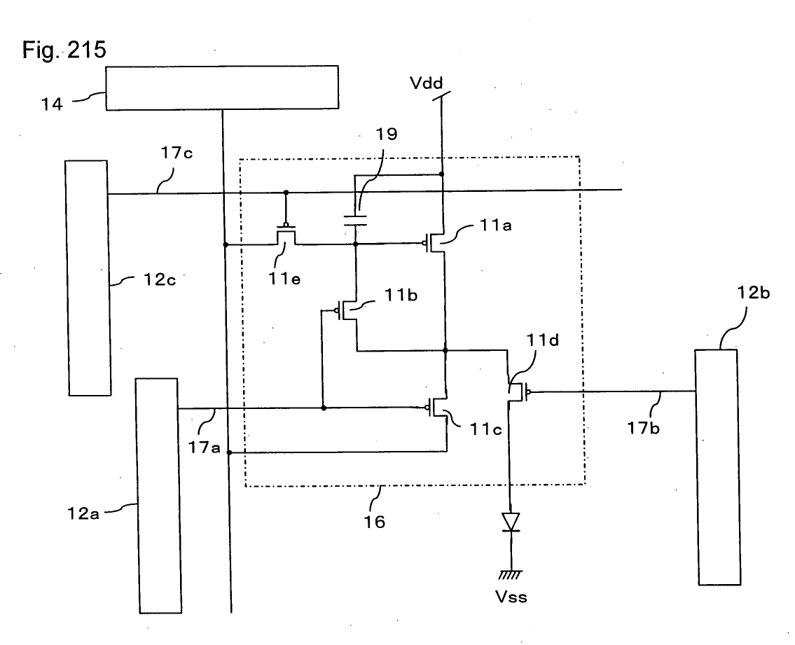

FIG. 215 is a variation of FIG. 211. The pixel configuration in FIG. 215 can be regarded as a combination of configurations in FIGS. 1 and 2 because it additionally contains a transistor 11e compared to the pixel configuration in FIG. 1. It also has a gate signal line 17c which controls the transistor 11e and a gate driver circuit 12c which applies a turn-off voltage sequentially to the gate signal line 17c in a scanning manner.

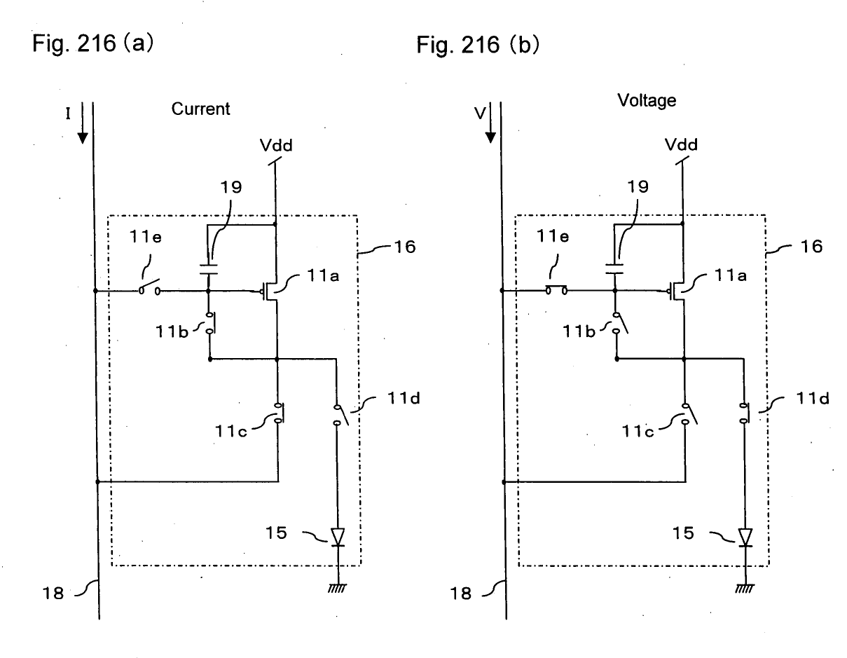

FIGS. 216(a) and 216(b) are explanatory diagrams illustrating the operation of the pixel in FIG. 215. FIG. 216(a) shows a pixel in drive mode for current programming while FIG. 216(b) shows a pixel in drive mode for voltage programming.

In FIG. 216(a), a turn-off voltage is applied to the gate signal line 17c to open (turn off) the transistor 11e. This state is the same as the pixel configuration in FIG. 1. By driving the pixel with a turn-off voltage constantly applied to the gate signal line 17c, it is possible to implement the drive method described with reference to FIG. 1 and the like, and thereby perform current programming.

In FIG. 216(b), a turn-off voltage is constantly applied to the gate signal line 17. Thus, the transistors 11b and 11c connected to the gate signal line 17a is kept off (open). In this state, the gate driver circuit 12c applies a turn-off voltage sequentially to the gate signal line 17c in a scanning manner. The transistor 11e in the selected pixel row turns on, causing the programming voltage V applied to the source signal line to be applied to the capacitor 19.

Incidentally, with the pixel configuration in FIG. 216(b), the transistor 11d does not necessarily have to be turned off (opened) during voltage programming and it may be either on or off as illustrated in FIG. 216(b). Needless to say, however, the transistor 11d must be turned on when current is passed through the EL element 15. The rest of the operation is the same as in the preceding,example, and thus description thereof will be omitted.

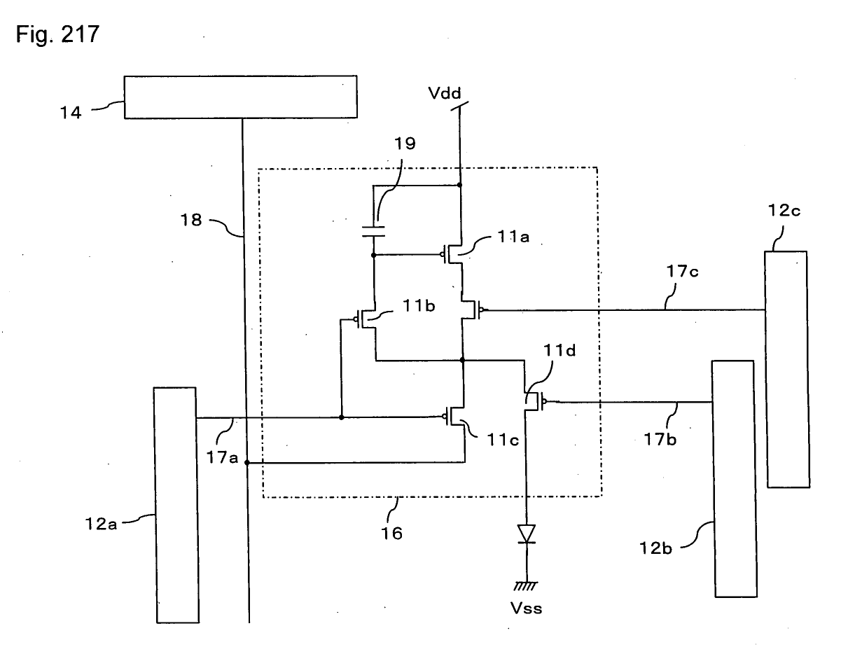

FIG. 217 is a variation of FIG. 212 or 215. In FIG. 217, the transistor 11e is formed or placed between the driver transistor 11a and the transistor 11d. The transistor 11e is turned on and off by the gate signal line 17c connected to the gate driver circuit 12c.

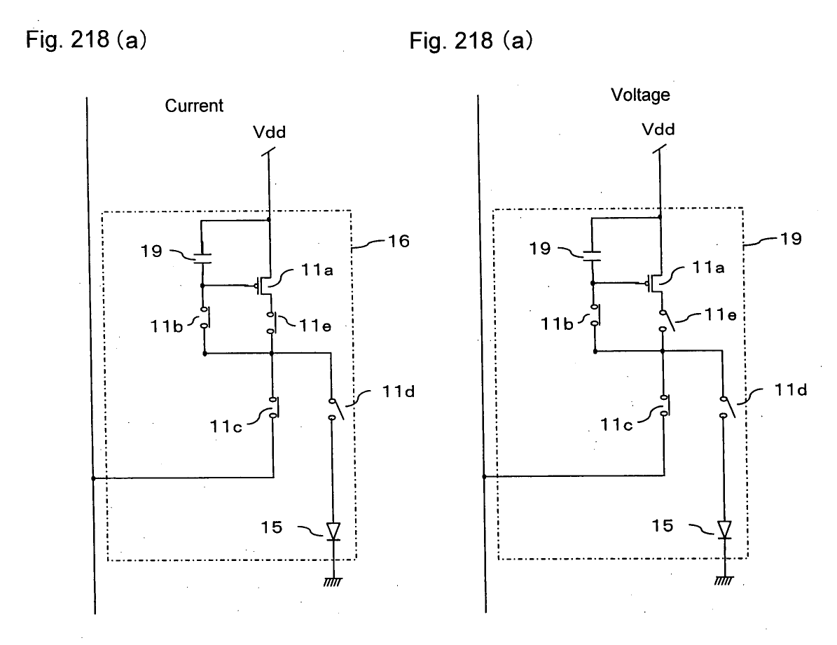

FIG. 218 is an explanatory diagram illustrating the operation of the pixel in FIG. 217. FIG. 218(a) shows a pixel in drive mode for current programming while FIG. 218(b) shows a pixel in drive mode for voltage programming.

In FIG. 218(a), a turn-on voltage is constantly applied to the gate signal line 17c and a turn-on voltage is applied to the gate signal line 17a of a selected pixel row. (Needless to say, the transistor 11e may be turned on when a pixel row is selected as in the case of FIG. 212. This similarly applies to FIG. 215.) Consequently, the transistors 11b and 11c turn on. In this state, a programming current Iw is applied to the source signal line 18 and written into the capacitor 19 of the selected pixel 16.

FIG. 218(b) shows a state in which voltage is written into a pixel during voltage programming. Basically, this state is the same as in the voltage programming mode in FIG. 2. A turn-off voltage is applied to the gate signal line 17c to turn off (open) the transistor 11e. Also, as in the case of FIG. 218(a), a turn-off voltage is applied to the gate signal line 17b to turn off the transistor 11d. In this state, the programming voltage V applied to the source signal line 18 is written into the capacitor 19 of the selected pixel 16. The rest of the operation is the same as in the preceding example, and thus description thereof will be omitted.

A particular problem encountered by the pixel configuration in FIG. 2 is that transient current flows through the EL element 15 when turning on and off power (cathode voltage and anode voltage supplied to the panel) This is because the power supply is turned off when the on/off state of the transistor 11 is unestablished and the potential state of the capacitor 19 is undetermined. This is also true when the power supply is off.

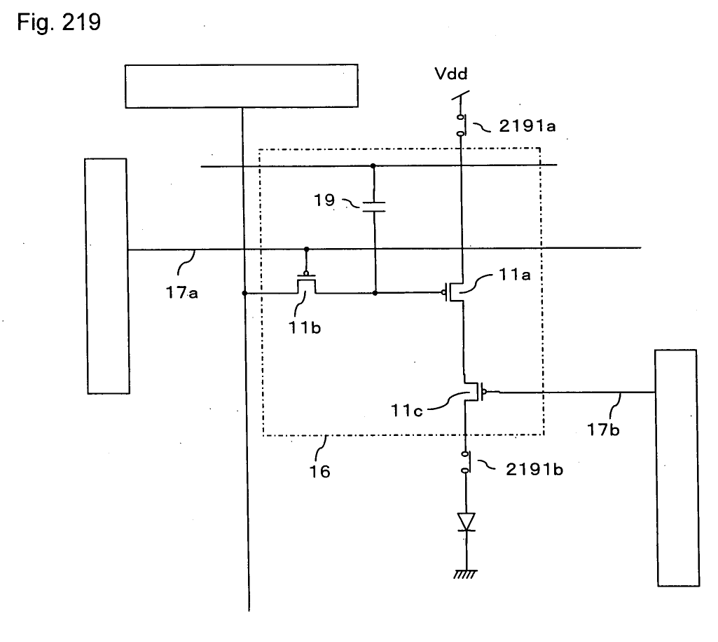

To solve this problem, a switching transistor 219a can be placed or formed between the anode and driver transistor 11a and a transistor 219b can be formed or placed between the driver transistor 11a and anode or EL element 15, as illustrated in FIG. 219.

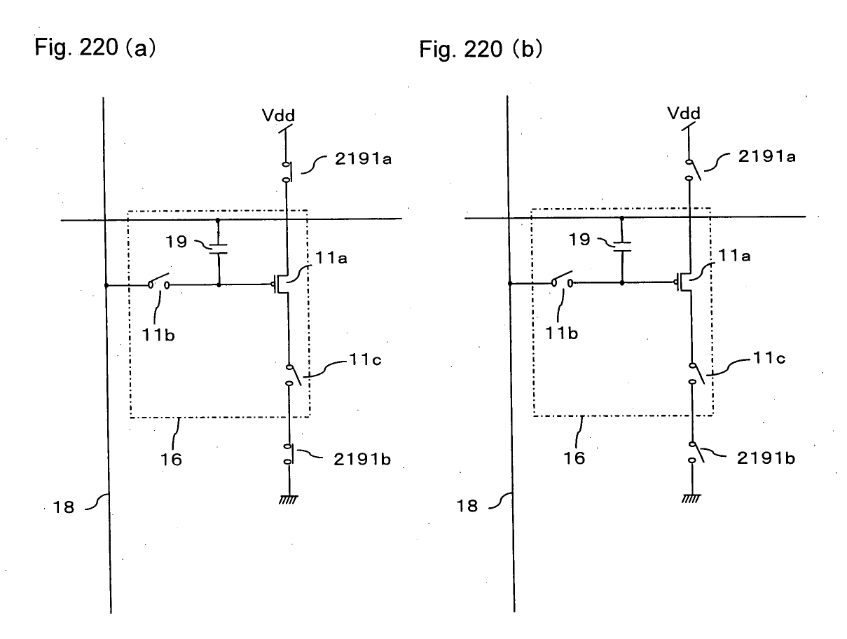

As illustrated in FIG. 220, before turning off the power, transistors 2191 are turned off by a controller. As illustrated in FIG. 220(a), one of transistors 2191a and 2191b may be turned off. Alternatively, both transistors 2191a and 2191b may be turned off before turning off the power circuit as illustrated in FIG. 220(b) Before turning on the power, the transistors 2191 are turned off by the controller. Preferably the transistors 2191 are turned on after turning on the power circuit.

It goes without saying that the items described with reference to FIGS. 219 and 220 also apply to other pixel configurations according to the present invention. Needless to say, the above effect is achieved if one of the transistors 2191a and 2191b shown in FIG. 219 is placed or formed.

Although it has been stated with reference to FIG. 219 that switching transistors 2191 are formed or placed in each pixel 16, this is not restrictive. It is alternatively possible to place one switching transistor 2191a on the anode terminal and one switching transistor 2191b on the cathode terminal.

Also, although the transistors 2191 are used in FIG. 219, this is not restrictive. Needless to say, thyristors, photodiodes, relay elements, or other elements may be used alternatively.

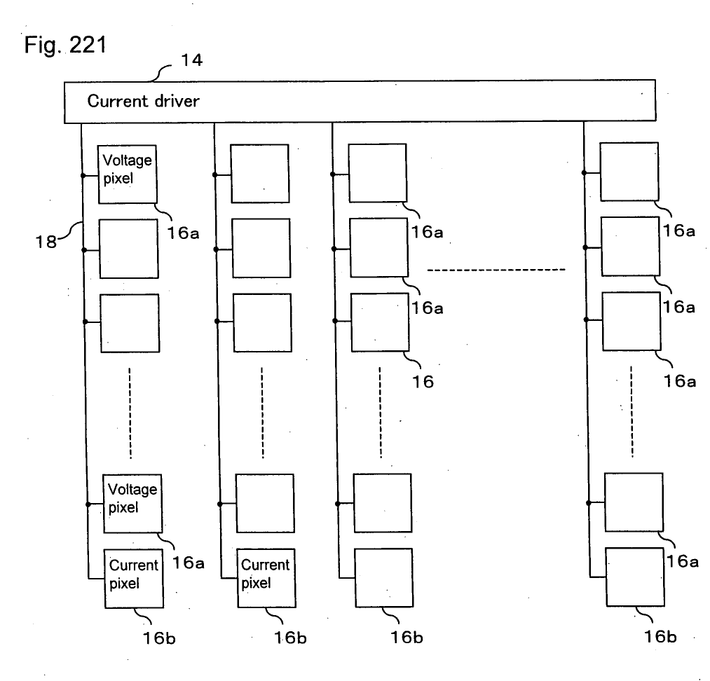

In the above example, the pixels formed or placed in the display area have a current-driven pixel configuration, a voltage-driven pixel configuration, or a pixel configuration switchable between current driving mode and voltage driving mode. However, the present invention is not limited to this. For example, the configuration shown in FIG. 221 may be used alternatively.

FIG. 221 shows a configuration in which current-driven pixels (FIG. 1, etc.) 16b and voltage-driven pixels (FIG. 2, etc.) 16a are connected to a single source signal line 18. The current-driven pixels 16b are formed or placed on one end of the source signal line 18 and are located away from the source driver circuit (IC) 14. The driver transistors 11a for the current-driven pixels 16b and the driver transistors 11a for the voltage-driven pixels 16a are made to coincide in WL.

The current-driven pixels 16b are turned on depending on such conditions as the magnitude of programming current (voltage), current is supplied through the source signal line 18, and the source signal line 18 is charged and discharged to program the pixels 16.

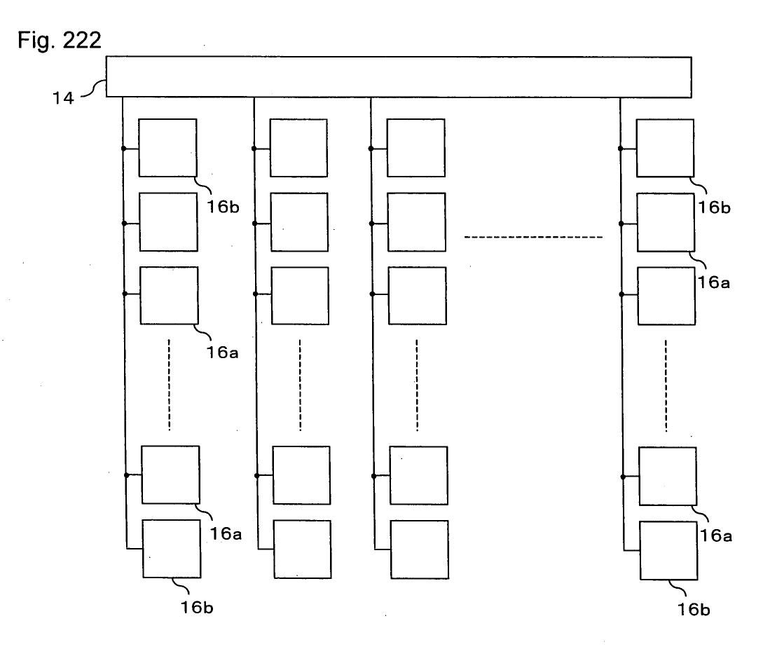

FIG. 222 shows a configuration in which the voltage-driven pixels 16a and current-driven pixels 16b of FIG. 221 are replaced with each other. As described above, the present invention forms or places both voltage-driven pixels 16a and current-driven pixels 16b in the display area.

According to the pixel configuration of the present invention, it can display RGB images in sequence by controlling switching means such as the transistors 11d (in the case of FIG. 1). Also see the configuration shown in FIG. 22.

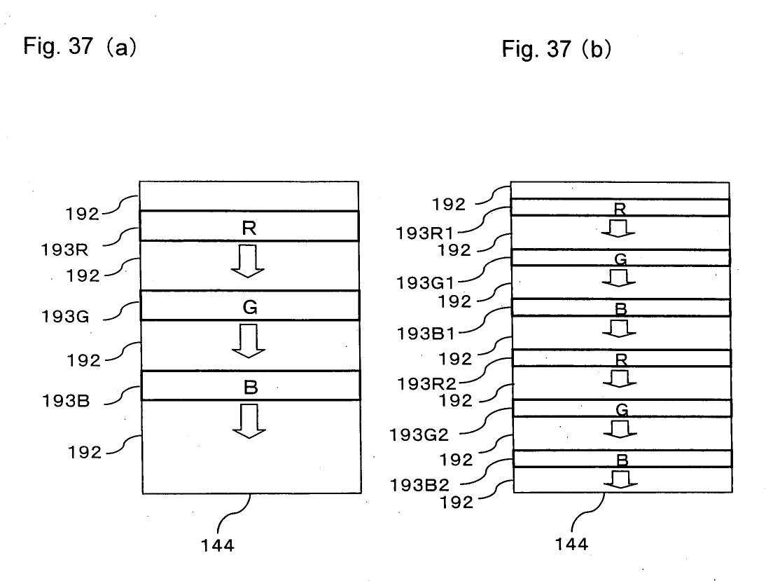

In FIG. 37(a), an R display area 193R, G display area 193G, and B display area 193B are scanned from top to bottom (or from bottom to top) of the screen during one frame (one field) period. The remaining area becomes a non-display area 52. That is, intermittent driving is performed. Intermittent display is performed separately in RGB display areas 193.

FIG. 37(b) shows an example in which a plurality of R, G, B display areas 193 are generated during one field (one frame) period. This drive method is analogous to the one shown in FIG. 23. Thus, it will require no explanation. In FIG. 37(b), by dividing the display area 193, it is possible to eliminate flickering even at a lower frame rate.

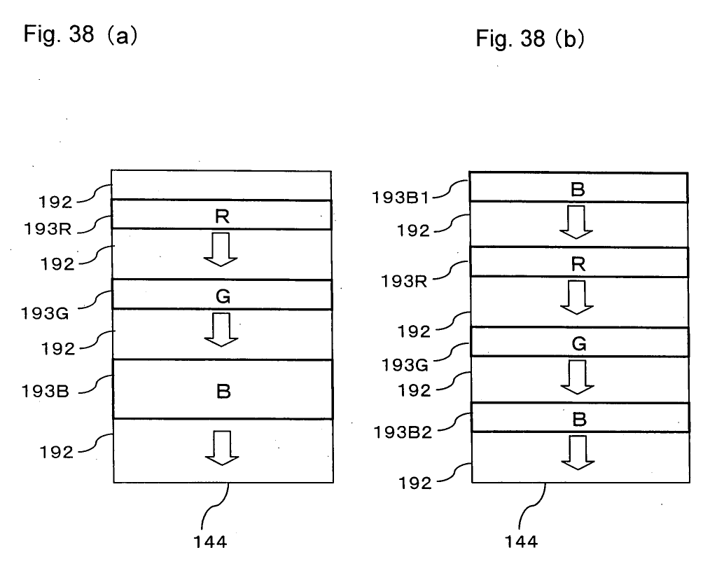

FIG. 38(a) shows a case in which R, G, and B display areas 193 have different sizes (needless to say, the size of a display area 193 is proportional to its illumination period). In FIG. 38(a), the R display area 193R and G display area 193G have the same size. The B display area 193B has a larger size than the G display area 193G.

In an organic EL display panel, B often has a low light emission efficiency. By making the B display area 193B larger than the display areas 193 of other colors as shown in FIG. 38(a), it is possible to achieve a white balance efficiently. Also variation of R, G, B display area 193 makes it realize the white balance adjustment and color temperature adjustment easily.

FIG. 38(b) shows an example in which there are a plurality of B display periods 193B (193B1 and 193B2) during one field (one frame) period. Whereas FIG. 38(a) shows a method of varying the size of one B display area 193B to allow the white balance to be adjusted properly. FIG. 38(b) shows a method of displaying multiple B display areas 193B having the same surface area to achieve a proper white balance adjustment (correction). This also achieves proper color temperature correction (adjustment). For example, it is useful to vary color temperature between indoor and outdoor environments, for example, decreasing the color temperature in indoor environments and increasing it in outdoor environments.

The drive method of the present invention is not limited to FIGS. 37 and 38. R, G, and B display areas 193 may be generated separately and brought up intermittently. This avoids blurred moving pictures and improves the insufficient writing to the pixel 16.

With the drive method in FIG. 23, independent display areas 193 for R, G, and B are not generated. R, G, and B are displayed simultaneously (it should be stated that a W display area 193 is presented).

It goes without saying that FIG. 38(a) and FIG. 38(b) may be combined. For example, it is possible to combine the drive method of using display areas 193 of different sizes for R, G, and B in FIG. 38(a) with the drive method of generating multiple display areas 193 for R, G, or B in FIG. 38(b).

Needless to say, if the drive method shown in FIGS. 37 to 38 has a configuration which controls the currents flowing through the EL elements 15 (EL elements 15R, EL elements 15G, and EL elements 15B) separately for R, G, and B as shown in FIG. 22, the drive method in FIGS. 37 and 38 can be implemented easily.

In the display panel configuration shown in FIG. 22, by applying turn-on/turn-off voltages to the gate signal line 17bR, it is possible to turn on and off the R pixel 16R. By applying turn-on/turn-off voltages to the gate signal line 17bG, it is possible to turn on and off the G pixel 16G. By applying turn-on/turn-off voltages to the gate signal line 17bB, it is possible to turn on and off the B pixel 16B.

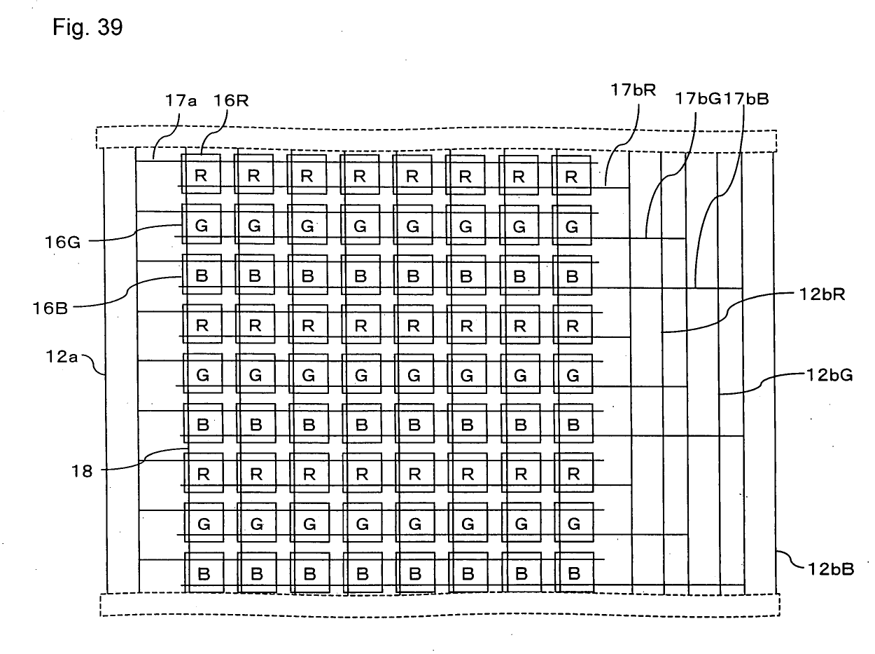

The above driving can be implemented by forming or placing a gate driver circuit 12bR which controls the gate signal line 17bR, a gate driver circuit 12bG which controls the gate signal line 17bG, and a gate driver circuit 12bB which controls the gate signal line 17bB, as illustrated in FIG. 39.

By driving the gate driver circuits 12bR, 12bG, and 12bB in FIG. 39 by the method described in FIGS. 19, 20, or the like, the drive method in FIGS. 37 and 38 can be implemented. Of course, it goes without saying that the drive methods in FIG. 23 and the like can be implemented using the configuration of the display panel in FIG. 39.

It has been stated with reference to FIGS. 20, 24, 26, 27, etc. that the gate signal line 17b (EL-side selection signal line) applies a turn-on voltage (Vgl) and turn-off voltage (Vgh) every horizontal scanning period (1 H). However, in the case of a constant current, light emission quantity of the EL elements 15 is proportional to the duration of the current. Thus the duration is not limited to 1 H. The followings can be applied to gate signal lines 17a (17a1, 17a2).

Here, a concept of output enable (OEV) is explained. By performing OEV control, turn-on and turn-off voltages (Vgl voltage and Vgh voltage) can be applied to the pixels 16 from the gate signal line 17a and 17b within one horizontal scanning period (1 H).

For ease of explanation, it is assumed that in the display panel according to the present invention, the pixel rows to be programmed with current are selected by the gate signal line 17a (in the case of FIG. 1). The output from the gate driver circuit 12a which controls the gate signal line 17a is referred to as a WR-side selection signal line. Also, it is assumed that EL elements 15 are selected by the gate signal line 17b (in the case of FIG. 1). The output from the gate driver circuit 12b which controls the gate signal line 17b is referred to as an EL-side selection signal line.

The gate driver circuits 12 are fed a start pulse, which is shifted as holding data in sequence within a shift register. Based on the holding data in the shift register of the gate driver circuit 12a, it is determined whether to output a turn-on voltage (Vgl) or turn-off voltage (Vgh) to the WR-side selection signal line. An OEV1 circuit (not shown) which turns off output forcibly is formed or placed in an output stage of the gate driver circuit 12a. When the OEV1 circuit is low, a WR-side selection signal which is an output of the gate driver circuit 12a is output as it is to the gate signal line 17a.

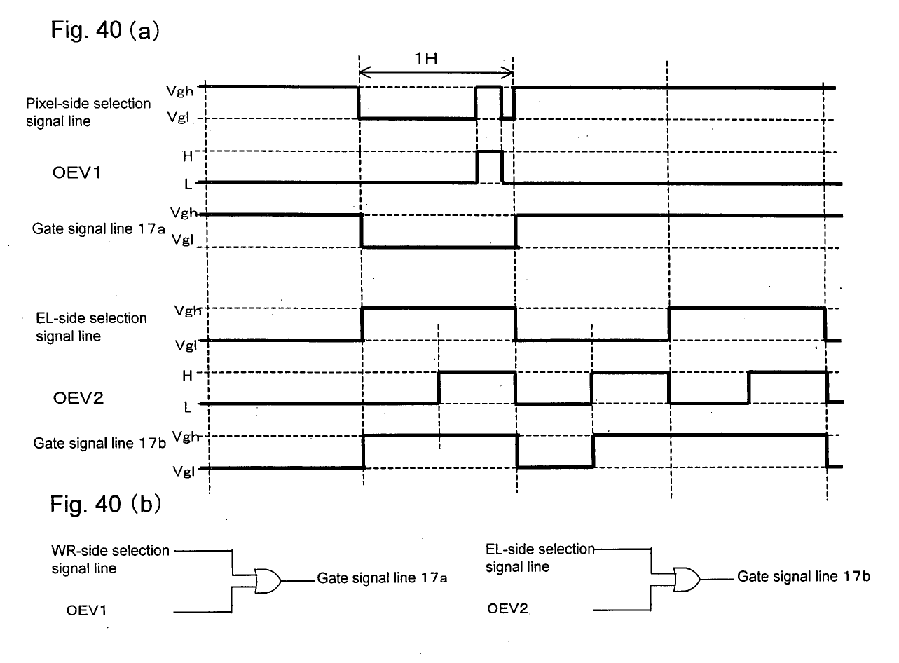

The above relationship is illustrated logically in OR circuit (see FIG. 40(b)). Incidentally, the turn-on voltage is set at logic level L (0) and the turn-off voltage is set at logic voltage H (1). When the gate driver circuit 12a outputs a turn-off voltage, the turn-off voltage is applied to the gate signal line 17a. When the gate driver circuit 12a outputs a turn-on voltage (logic low), it is ORed with the output of the OEV1 circuit by the OR circuit and the result is output to the gate signal line 17a. When the OEV1 circuit is high, the turn-off voltage (Vgh) is output to the gate driver signal line 17a (see an exemplary timing chart in FIG. 40(a)).

Based on holding data in a shift register of the gate driver circuit 12b, it is determined whether to output a turn-on voltage (Vgl) or turn-off voltage (Vgh) to the gate signal line 17b (EL-side selection signal line). An OEV2 circuit (not shown) which turns off output forcibly is formed or placed in an output stage of the gate driver circuit 12b.

When the OEV2 circuit is low, an output of the gate driver circuit 12b is output as it is to the gate signal line 17b. The above relationship is illustrated logically in FIG. 40(a). Incidentally, the turn-on voltage is set at logic level L (0) and the turn-off voltage is set at logic voltage H (1).

When the gate driver circuit 12b outputs a turn-off voltage (an EL-side selection signal is a turn-off voltage), the turn-off voltage is applied to the gate signal line 17b. When the gate driver circuit 12b outputs a turn-on voltage (logic low), it is ORed with the output of the OEV2 circuit by the OR circuit and the result is output to the gate signal line 17b. That is, when an input signal is high, the OEV2 circuit outputs the turn-off voltage (Vgh) to the gate driver signal line 17b. Thus, even if the EL-side selection signal from the OEV2 circuit is a turn-on voltage, the turn-off voltage (Vgh) is output forcibly to the gate signal line 17b. Incidentally, if an input to the OEV2 circuit is low, the EL-side selection signal is output directly to the gate signal line 17b (see the exemplary timing chart in FIG. 40(a)).

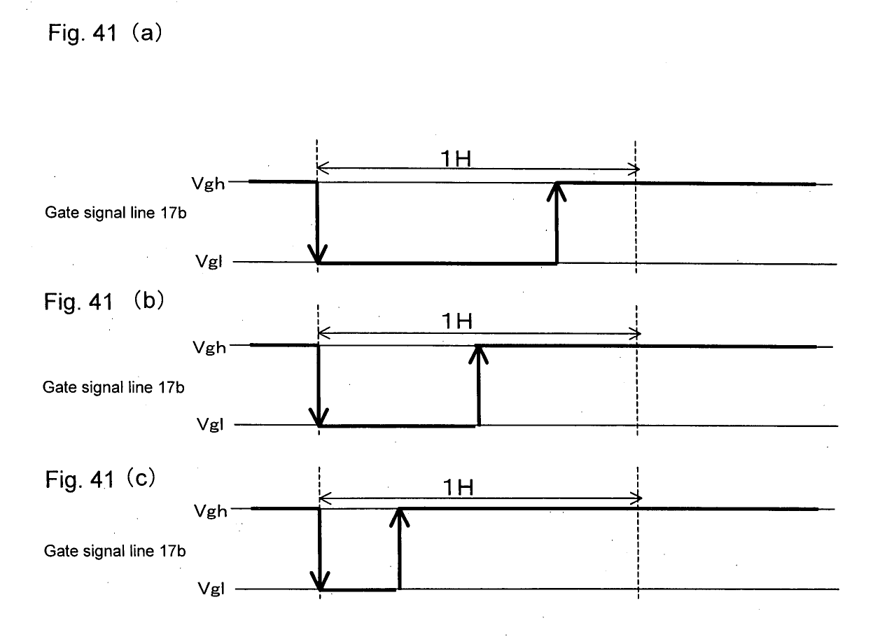

By adjusting the duration of application of the turn-on voltage to the gate signal line 17b (EL-side selection signal line), it is possible to adjust the brightness of the display screen 144 linearly. This can be done easily through control of the OEV2 circuit. Referring to FIG. 41, for example, display brightness in FIG. 41(b) is lower than in FIG. 41(a). Also, display brightness in FIG. 41(c) is lower than in FIG. 41(b).

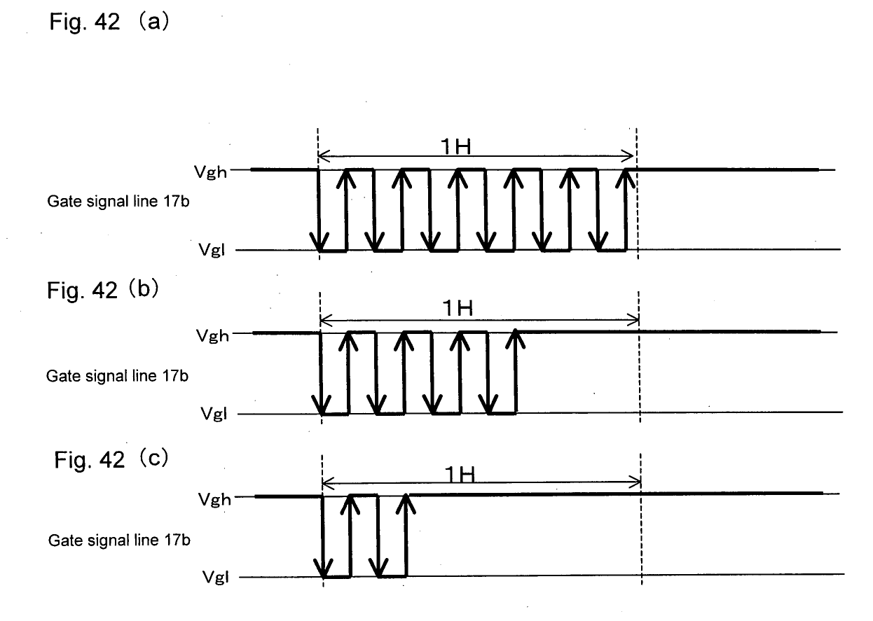

As shown in FIG. 42, multiple sets of turn-on voltage and turn-off voltage may be applied in a period of 1 H. FIG. 42(a) shows an example in which six sets are applied. FIG. 42(b) shows an example in which three sets are applied. FIG. 42(c) shows an example in which one set is applied. In FIG. 42, display brightness is lower in FIG. 42(b) than in FIG. 42(a). It is lower in FIG. 42(c) than in FIG. 42(b). Thus, by controlling the number of conduction periods, display brightness can be adjusted (controlled) easily.

The current-driven source driver circuit (IC) 14 according to the present invention will be described below. The source driver IC according to the present invention is used to implement the drive methods and drive circuits according to the present invention described earlier. It is used in combination with drive methods, drive circuits, and display apparatus according to the present invention.

Incidentally, although the source driver circuit is described in the examples in the present invention as an IC chip, this is not restrictive and the source driver circuit may be built directly on the board 30 of the display panel using high-temperature polysilicon technology, low-temperature polysilicon technology, CGS technology, amorphous silicon technology, or the like. Also, a source driver circuit (IC) 14 formed on a silicon wafer may be transferred to a substrate 30.

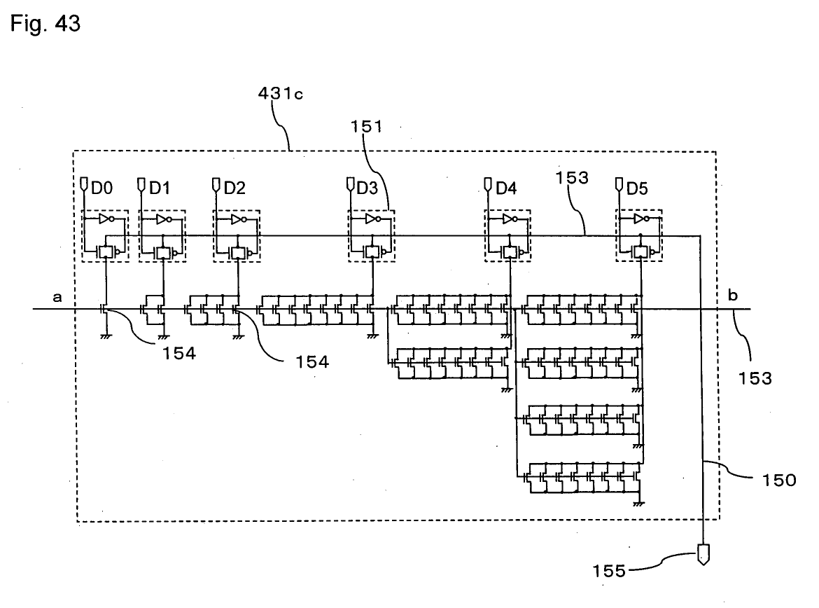

FIG. 43 is a structural drawing of one output stage of the source driver circuit (IC) 14. This is an output part connected to one source signal line 18. It is composed of multiple unit transistors 154 (1 unit) of the same size. Their number is bit-weighted according to the data size of image data. FIG. 43 shows an example of 64-gradation display. The transistor group 431c in one output stage consists of 63 unit transistors 154.

The transistors or transistor groups composing the source driver circuit (IC) 14 according to the present invention are not limited to a MOS type and may be a bipolar type. Also, they are not limited to silicon semiconductors and may be gallium arsenide semiconductors. They may be germanium semiconductors. Alternatively, they may be formed or configured using low-temperature polysilicon technology, high-temperature polysilicon technology, and CGS technology.

FIG. 43 illustrates an example of the present invention which handles 6-bit digital input. Six bits are the sixth power of two, and thus provide a 64-gradation display. This source driver IC 14, when mounted on an array board, provides 64 gradations each of red (R), green (G), and blue (B), meaning 64×64×64=approximately 260,000 colors.

Sixty-four (64) gradations require 1 D0-bit unit transistor 154, two D1-bit unit transistors 154, four D2-bit unit transistors 154, eight D3-bit unit transistors 154, sixteen D4-bit unit transistors 154, and thirty-two D5-bit unit transistors 154 for a total of 63 unit transistors 154. Thus, the present invention produces one output using as many unit transistors 154 as the number of gradations (64 gradations in this example) minus 1.

Even if one unit transistor is divided into a plurality of sub-unit transistors, this means that a unit transistor is divided into a plurality of sub-unit transistors. For example, a unit transistor 154 is configured by four sub-unit transistors. It makes no difference in the fact that the present invention uses as many unit transistors as the number of gradations minus 1.

Although the 32 D5-bit unit transistors 154 in FIG. 43 are placed (formed) densely, the present invention is not limited to this. For example, they may be divided into groups of eight unit transistors 154 (i.e., four 8-transistor groups) and the resulting transistor groups maybe placed (formed) in a distributed manner. This will reduce variations in output current.

In FIG. 43, D0 represents LSB input and D5 represents MSB input. When a D0 input terminal is high (positive logic), a switch 151a is closed (the switch 481a is an on/off means and may be constructed of a single transistor or may be an analog switch consisting of a P-channel transistor and N-channel transistor. Then, current flows to a unit transistor 154 composing a current mirror. The current flows through internal wiring 153 in the IC 14. Since the internal wiring 153 is connected to the source signal line 18 via a terminal electrode of the IC 14, the current flowing through internal wiring 153 provides a programming current for the pixels 16.

For example, when a D1 input terminal is high (positive logic), a switch 151 is closed. Then, current flows to two unit transistors 154 composing a current mirror. The current flows through the internal wiring 153 in the IC 14. Since the internal wiring 153 is connected to the source signal line 18 via a terminal electrode of the IC 14, the current flowing through internal wiring 153 provides a programming current for the pixels 16.

The same applies to the other switches 151. When a D2 input terminal is high (positive logic), a switch 151c is closed. Then, current flows to four unit transistors 154 composing a current mirror. When a D5 input terminal is high (positive logic), a switch 151f is closed. Then, current flows to 32 (thirty-two) unit transistors 154 composing a current mirror.

In this way, based on external data (D0 to D5), current flows to the corresponding unit transistors. That is, current flows to 0 to 63 unit transistors depending on the data.

Incidentally, for ease of explanation, it is assumed that there are 63 current sources for a 6-bit configuration, but this is not restrictive. In the case of 8-bit configuration, 255 unit transistors 154 can be formed (placed). For a 4-bit configuration, 15 unit transistors 154 can be formed (placed). Of course, in the case of 8-bit configuration, 255×2 unit transistors 154 can be formed (placed). Two single-unit transistors 154 can output single-unit current. The unit transistors 154 constituting the unit current sources have a channel width W and channel width L. The use of equal transistors makes it possible to construct output stages with small variations.

Not all the unit transistors 154 need to pass equal current. For example, individual unit transistors 154 may be weighted. For example a current output circuit may be constructed using a mixture of single-unit unit transistors 154, double-sized unit transistors 154, quadruple-sized unit transistors 154, etc.

However, if unit transistors 154 are weighted, the weighted current sources may not provide the right proportions, resulting in variations. Thus, even when using weighting, it is preferable to construct each current source from transistors each of which corresponds to a single-unit current source.

Programming current Iw is output (drawn) to the source signal line via switches controlled by 6-bit image data consisting of D0, D1, D2, . . . , and D5. Thus, according to activation and deactivation of the 6-bit image data consisting of D0, D1, D2, . . . , and D5, 1 time, 2 times, 4 times, . . . and/or 32 times larger currents are added and outputted to the output line. That is, according to activation and deactivation of the 6-bit image data consisting of D0, D1, D2, . . . , and D5, a programming current is output from the output line 153 (the current is drawn from the source signal line 18.).

In order to achieve full-color display on an EL display panel, it is necessary to provide a reference current for each of R, G, and B. The white balance can be adjusted by controlling the ratios of the RGB reference currents. The value of current passed by the unit transistor 154 is determined based on a reference current. Thus, the current passed by the unit transistor 154 can be determined by determining the magnitude of the reference current. Consequently, the white balance in every gradation can be achieved by setting a reference current for each of R, G, and B. The above matters work because the source driver circuit (IC) 14 produces current outputs varied in steps (is current-driven).

The gate terminals (G) of the unit transistors 154 in the transistor group 431c are connected to common gate wiring 153. Further, the source terminals (S) of the unit transistors 154 are connected to common internal wiring 150 at one end of which a terminal 155 is formed. The drain terminals (D) of the unit transistors 154 are connected to the ground potential (GND).

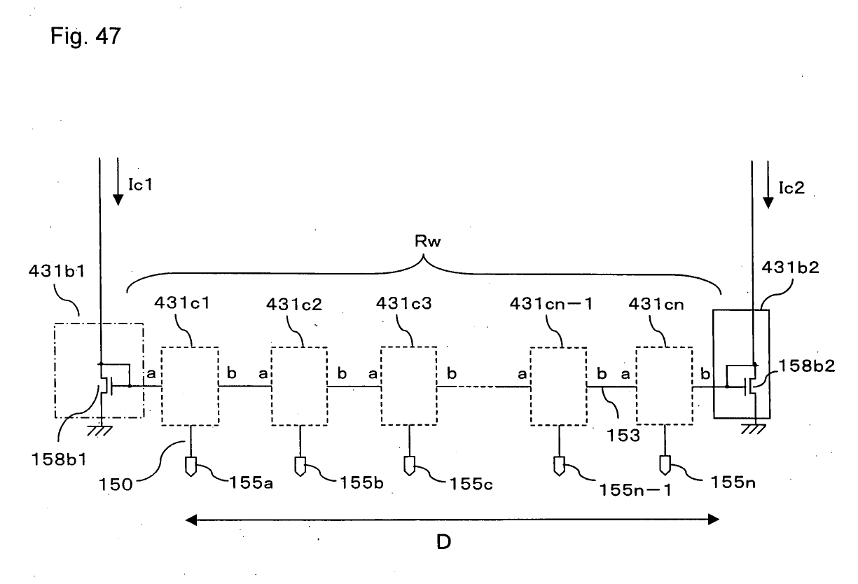

One transistor group 431c corresponds to one source signal line 18. Also, as illustrated in FIG. 47, the unit transistors 154 compose current mirror circuits together with the transistor 158b1 or transistor 158b2. A reference current Ic flows through the transistor 158b to determine the output current of the unit transistors 154.

As illustrated in FIG. 47, the gate terminal (G) of the driver transistor 158b and gate terminals (G) of the unit transistors 154 are connected to common gate wiring 153. Accordingly, the transistor 158b and transistor groups 431c compose current mirror circuits.

By placing the transistor 158b1 and transistor 158b2 on both sides of the transistor groups 431c as illustrated in FIG. 47, it is possible to reduce the potential gradient of the gate wiring 153. This equalizes the output currents of the transistor groups (431c1 and 431cn) on the left and right ends (provided that the output currents represent the same gradation) Also, by adjusting the magnitudes of the reference currents Ic1 and Ic2, it is possible to vary the potential gradient of the gate wiring 153 and adjust the magnitudes of the output currents of the transistor groups (431c1 and 431cn) on the left and right ends.

In FIG. 47, the transistor group 431c and the transistor 158b compose current mirror circuits. In reality, however, the transistor 158b consists of a plurality of transistors. Thus, the transistor group 431b which consists of a plurality of transistors 158b and the transistor group 431c compose the current mirror circuit. The gate terminals of the transistors 158b and gate terminals of the unit transistors 154 are connected with each other via common gate wiring 153.

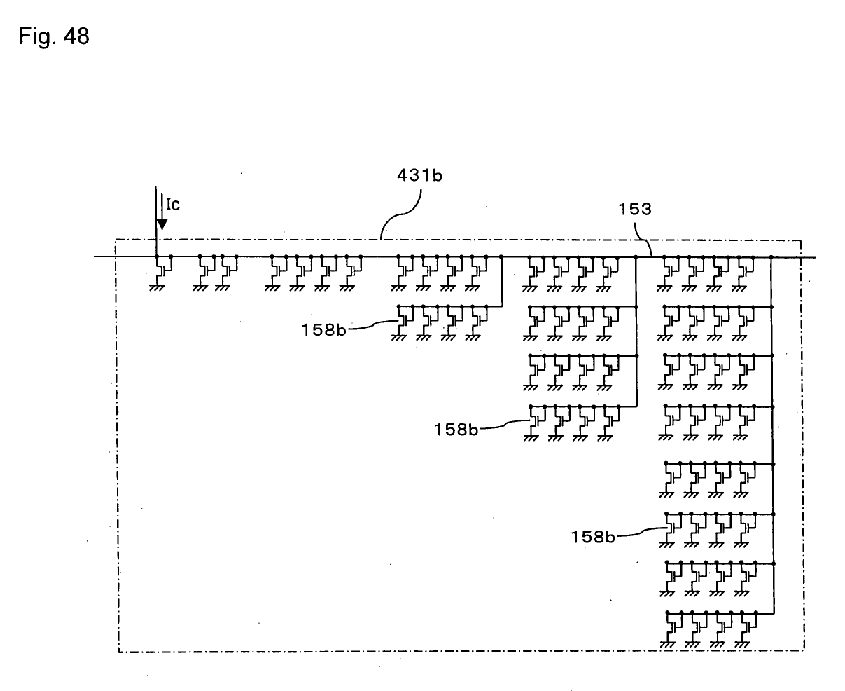

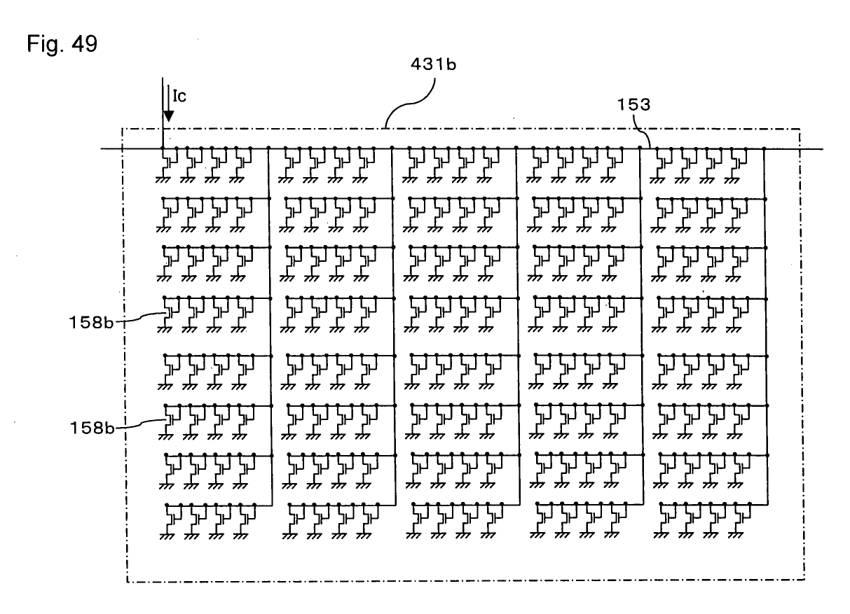

FIG. 48 shows a layout configuration of transistors 483b in a transistor group 431b. One transistor group 431b includes 63 transistors 158b, i.e., as many transistors as there are unit transistors 154 in the transistor group 431c Of course, the number of transistors 158b in one transistor group 431b is not limited to 63. If the unit transistor group 431c contains as many unit transistors 154 as the number of gradations minus 1, the transistor group 431b also contains as many transistors 158b or approximately as many transistors 158b as the number of gradations minus 1. Incidentally, the configuration in FIG. 48 is not restrictive. Transistors may be formed or placed in a matrix as shown in FIG. 49.

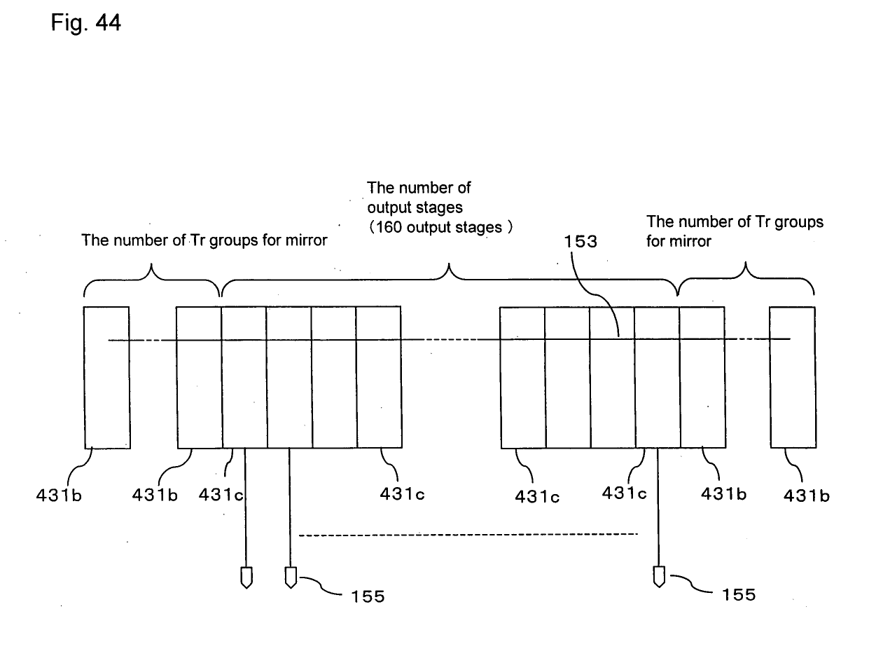

The configuration is schematically shown in FIG. 44. As many unit transistor groups 431c as there are output terminals are placed in parallel. Multiple transistor groups 431b are formed on both sides of the unit transistor groups 431c. The gate terminals of the transistors 158b in the transistor groups 431b and unit transistors 154 in the unit transistor groups 431c are connected with each other via gate wiring 153.

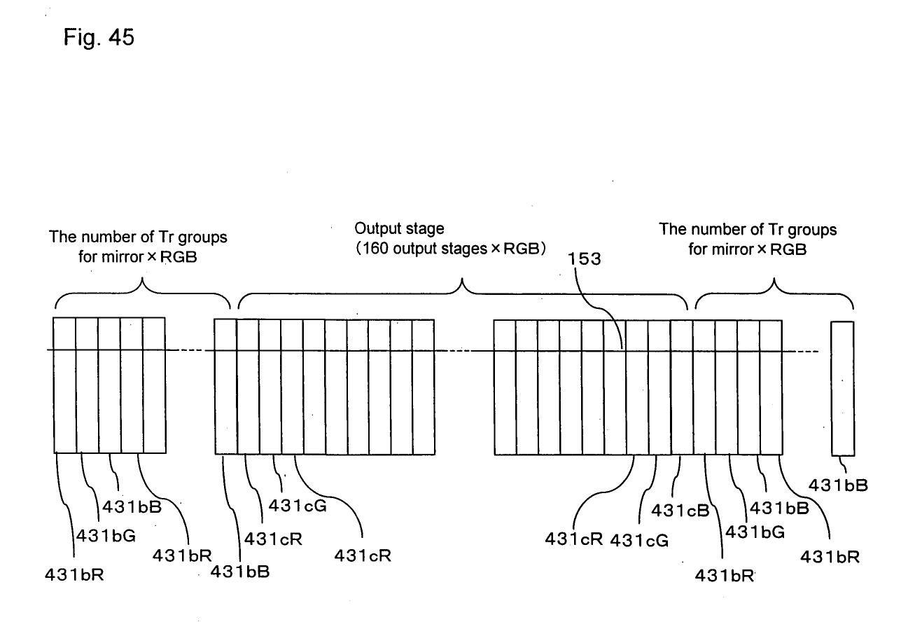

For ease of explanation, the source driver IC 14 has been treated above as if it were monochromatic. Actually, the source driver IC 14 is configured as shown in FIG. 45. That is, transistor groups 431b for red (R), green (G), and blue (B) are arranged in turns, and so do unit transistor groups 431c for red (R), green (G), and blue (B). In FIG. 45, reference numerals with a subscript R denote transistor groups for red (R), reference numerals with a subscript G denote transistor groups for green (G), and reference numerals with a subscript B denote transistor groups for Blue (B). By arranging transistor groups for R, G, and B by turns as described above, it is possible to reduce output variations among R, G, and B. This is also important for layout in the source driver circuit (IC) 14.

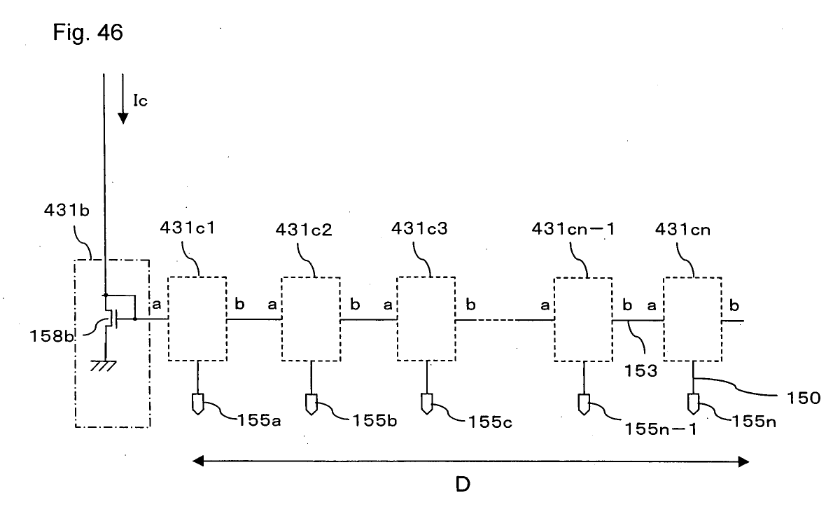

In FIG. 47, the transistors 158b (158b1 and 158b2) are formed or placed on both sides of the transistor groups 431c to 431cn. The present invention is not limited to this. The transistor 158 may be formed only on one side as illustrated in FIG. 46.

In FIG. 46, the transistor group 431b (transistor 158b) which passes reference current is placed near the outer periphery of the IC chip. The transistor group is composed of multiple transistors 158b rather than a single transistor. For ease of explanation, it is assumed here that the transistor group 431b consists of the transistor 158b. This item also applies to other examples of the present invention.

In FIG. 46, the transistor 158b is formed outside the IC chip (at an end of the chip). However, the present invention is not limited to this. For example, the transistors 158b3 may be formed or placed in the center area of the gate wiring 153 or the like as illustrated in FIG. 554. This increases stability of the gate wiring 153, eliminating horizontal cross-talk. Thus, it is also preferable to form, on the gate wiring 153, transistors 158b which pass a plurality of reference currents. Needless to say, by reducing the resistance of the gate wiring 153, it is possible to increase its stability.

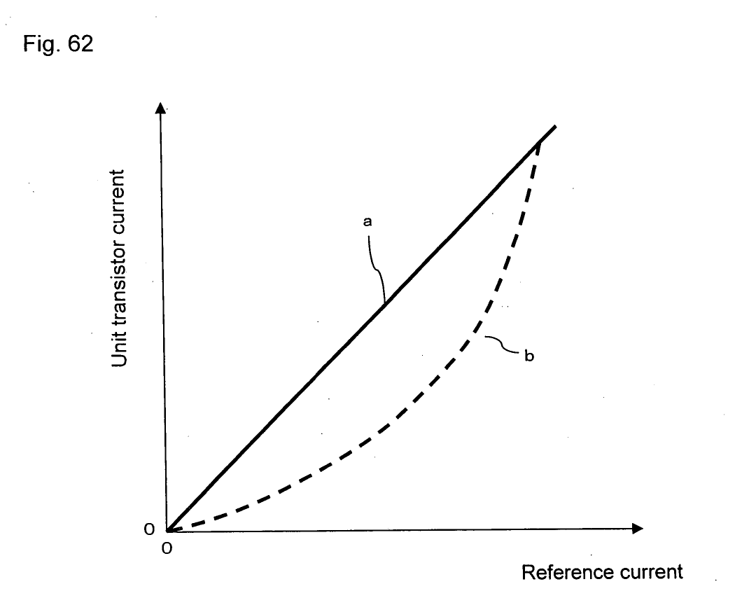

As described with reference to FIG. 62, by connecting a capacitor 19 to the gate wiring 153, it is possible to stabilize its potential. The capacitor 19 may be connected externally to a terminal of the source driver IC chip 14. Needless to say, even if the source driver circuit (IC) 14 is formed directly on a substrate 30 by low-temperature polysilicon technology or the like, formation of the capacitor 19 improves the stability of the gate wiring 153.

In FIG. 555, a source driver IC 14a has, on its right end, a transistor 158b2 which passes a reference current while its left end is open. Thus, the reference current Ic2 flows through the transistor 158b2 (gate wiring 153a passes only current that flows to the gate terminals of the unit transistors 154). Incidentally, it is assumed that the reference currents Ic1 and Ic2 are equal. An output terminal 155a1 outputs a current by accurately mirroring the transistor 158b2 which forms a current mirror circuit.

A source driver IC 14b has, on its left end, a transistor 158b1 which passes a reference current while its right end is open. Thus, the reference current Ic1 flows through the transistor 158b1 (gate wiring 153b passes only current that flows to the gate terminals of the unit transistors 154). An output terminal 155a2 outputs a current by accurately mirroring the transistor 158b1 which forms a current mirror circuit. Thus, if it is assumed that the reference currents Ic1 and Ic2 are equal, gradation current outputted from the output terminal 155a1 of the source driver IC 14a and gradation current outputted from an output terminal 155a2 of the source driver IC 14b are equal. For these reasons, the two source drivers ICs 14a and 14b are cascaded properly.

In FIG. 555, the gradation current (programming current) outputted from a terminal 155a3 at the right end of the source driver IC 14a and gradation current (programming current) outputted from the terminal 155a1 of the source driver IC 14a are not necessarily equal. This is because the gradation currents vary with the characteristics of the unit transistors 154 in the IC chip 14a.

Also, the gradation current outputted from a terminal 155a2 at the right end of the source driver IC 14b and gradation current outputted from the terminal 155a3 of the source driver IC 14b are not necessarily equal. This is because the gradation currents vary with the characteristics of the unit transistors 154 in the IC chip 14b. However, since the cascaded source driver IC 14 includes two chips, there is no problem if the gradation current from the output terminal 155a1 of the source driver IC 14a and the gradation current from the output terminal 155a2 of the source driver IC 14b are equal. Thus, the gate wiring 153 may be made of low resistance wires.

To implement the configuration shown in FIG. 555, it is necessary to open one of the transistors 158b at both ends of the gate wiring 153 of the IC chip 14a (so that no current will flow through the transistors 158b) as shown in FIG. 556. In FIG. 556, the terminals of the transistor 158b1 in the source drive IC 14a are open except the gate terminal. Consequently, no current flows from the gate wiring 153a into the transistor 158b1. Also, the terminals of the transistor 158b2 in the source drive IC 14b are open except the gate terminal. Consequently, no current flows from the gate wiring. 153b into the transistor 158b2.

FIG. 557 shows another example of the present invention. When current flows through the gate wiring 153, the current flowing through the transistors 158b deviates from its normal value, resulting in errors in the gradation output current. The reason why the current flows through the gate wiring 153 is that there are differences in characteristics (especially Vt) between the left and right sides of the IC chip, causing differences in gate terminal voltage between the transistor 158b1 and transistor 158b2.

To reduce the effect of differences in the gate terminal voltage, the present invention alternates a state in which the reference current Ic1 is passed through the transistor 158b1 (see FIG. 557(a), where no current flows through the transistor 158b2) and a state in which the reference current Ic2 is passed through the transistor 158b2 as illustrated in FIG. 557 (see FIG. 557(b), where no current flows through the transistor 158b1).

Preferably, the drain terminal of the transistor 158b2 is also opened in FIG. 557(a) as illustrated in FIG. 556, and preferably, the drain terminal of the transistor 158b1 is also opened in FIG. 557(b).

The state shown in FIG. 557(a) and state shown in FIG. 557(b) occur in one horizontal scanning period. That is, the state shown in FIG. 557(a) and state shown in FIG. 557(b) should occur in the same horizontal scanning period. In FIG. 557(a), the switches 5571a and 5571c are closed to pass the reference current Ic1 through the transistor 158b1. At this time, the switches 5571b and 5571d are kept open. Thus, no current flows through the transistor 158b2. The transistor group 431c is driven by the above actions, forming a current mirror circuit in conjunction with the transistor 158b1.

In the next ½ H period (half the horizontal scanning period) (FIG. 557(b)), the switches 5571b and 5571d are closed to pass the reference current Ic2 through the transistor 158b2. At this time, the switches 5571a and 5571c are kept open. Thus, no current flows through the transistor 158b1. The transistor group 431c is driven by the above actions, forming a current mirror circuit in conjunction with the transistor 158b2.

By repeating the states in FIG. 557(a) and FIG. 557(b) alternately, the present invention alternates a period in which the transistor group 431c forms a current mirror circuit in conjunction with the transistor 158b1 and a period in which the transistor group 431c forms a current mirror circuit in conjunction with the transistor 158b2. This reduces irregularities in characteristics between the left and right sides of the IC chip 14.

Although in the above example, the states in FIG. 557(a) and FIG. 557(b) alternate in one horizontal scanning period, this is not restrictive. They may alternate in a period longer than or shorter than one horizontal scanning period.

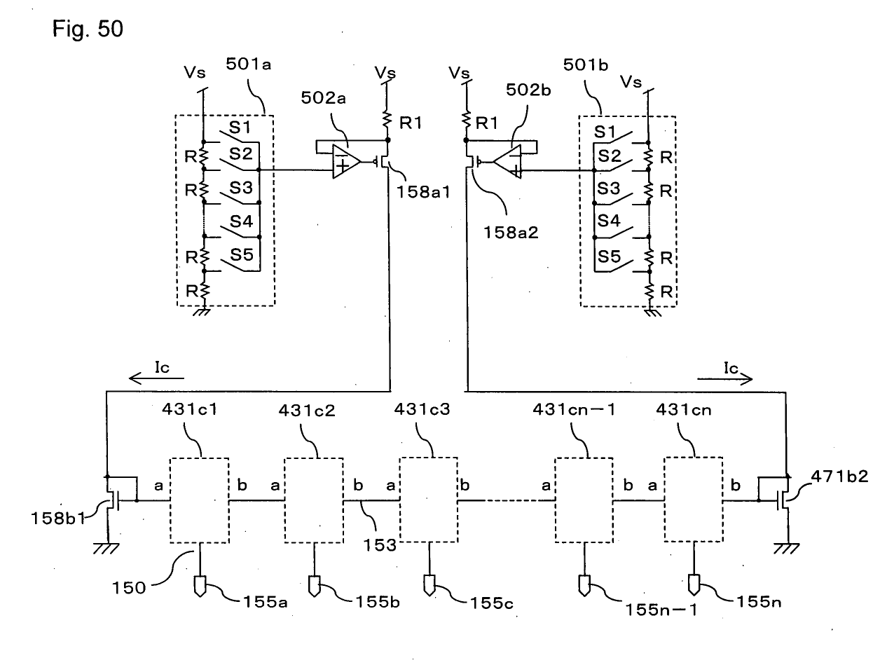

Preferably, the reference current Ic is generated by an electronic regulator 501, operational amplifier 502, and the like as illustrated in FIG. 50. The electronic regulator 501, operational amplifier 502, and the like are incorporated in the source driver IC 14. The electronic regulator 501 contains a ladder resistor R, which divides a reference voltage Vs (or IC power supply voltage).

An output voltage from the ladder resistor R is selected by a switch S and applied to the positive terminal of the operational amplifier 502. A reference current Ic is generated from the applied voltage and an external resistor R1 of the source driver IC 14. The use of the external resistor R1 makes it possible to adjust the value of the reference current using the value of R1. Also, white balance can be achieved easily by adjusting the external resistors of the R, G, and B circuits.

In the examples of the present invention, the operational amplifier 502 is sometimes used as a buffer as well as an analog processing circuit such as an amplifier circuit. Also, it may be treated as a comparator.

In the configuration shown in FIG. 50, the electronic regulators 501a and 501b can be operated independently. Thus, the values of the currents flowing through the transistors 158a1 and 158a2 can be changed. This makes it possible to adjust the currents passed through the transistors 158b (158b1 and 158b2) on the left and right sides of the chip and adjust the potential gradient of the gate wiring 153.

The unit transistor 154 should be equal to or larger than a certain size. The smaller the transistor size, the larger the variations in output current. The size of a unit transistor 154 is given by the channel length L multiplied by the channel width W. For example, if the channel width W=3 μm and the channel length L=4 μm, the size of the unit transistor 154 constituting a unit current source is W×L=12 square μm.

It is believed that crystal boundary conditions of silicon wafers have something to do with the fact that a smaller transistor size results in larger variations. Thus, variations in output current of transistors are small when each transistor is formed across a plurality of crystal boundaries.

FIGS. 44 and 48, let Sb denote the total area of the transistors 158b in each transistor group 431b (where the total area is the number of transistor groups 431b multiplied by the W and L sizes of the transistors 158b in each transistor group 431b multiplied by the number of the transistors 158b). If the transistor group 431b consists of a single transistor 1.58b, needless to say, Sb equals the size of the W and L sizes of the transistor 158b multiplied by the number of the transistor group 431b. In view of the above, let Sb denote the total area of the transistor 158b.

Let Sc (square pm) denote the total area of the unit transistors 154 in each transistor group 431c (where the total area is the W and L sizes of the unit transistors 154 in each transistor group 431c multiplied by the number of the unit transistors 154). It is assumed that the number of the transistor groups 431c is n (n is an integer). In the case of a QCIF+panel, n is 176 (a reference current circuit is formed for each of R, G, and B). Thus, n×Sc (square pm) provides the total area of the unit transistors 154 which compose current mirror circuits in conjunction with the transistors 158b in the transistor group 431b (i.e., which share the gate wiring 153 with the transistors 158b).

The swing of the gate wiring 153 is increased with increases in Sc×n/Sb. A large value of Sc×n/Sb means that the total area of the unit transistors 154 in the transistor groups 431c is larger than the total area of the transistors 158b in the transistor groups 431b when the number n of output terminals is constant. The swing of the gate wiring 153 is increased. The swing of the gate wiring 153 is increased accordingly.

A small value of Sc×n/Sb means that the total area of the unit transistors 154 in the transistor groups 431c is smaller than the total area of the transistors 158b in the transistor groups 431b when the number n of output terminals is constant. In that case, the swing of the gate wiring 153 is small.

An allowable range of the swing of the gate wiring 153 corresponds to a value of Sc×n/Sb of 50 or less. When Sc×n/Sb is 50 or less, the fluctuation ratio falls within the allowable range and potential fluctuations of the gate wiring 153 is extremely small. This makes it possible to eliminate horizontal cross-talk, keep output variations within an allowable range, and thus achieve proper image display.

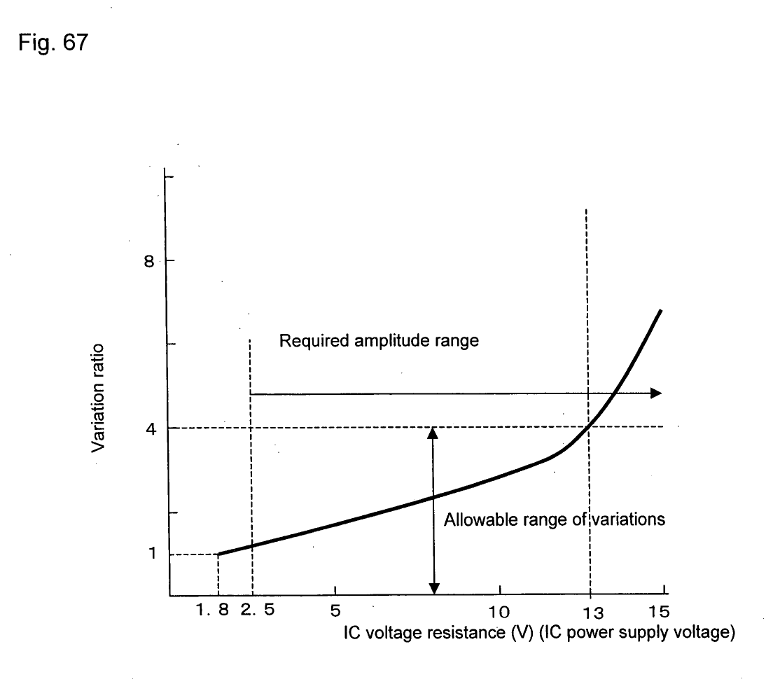

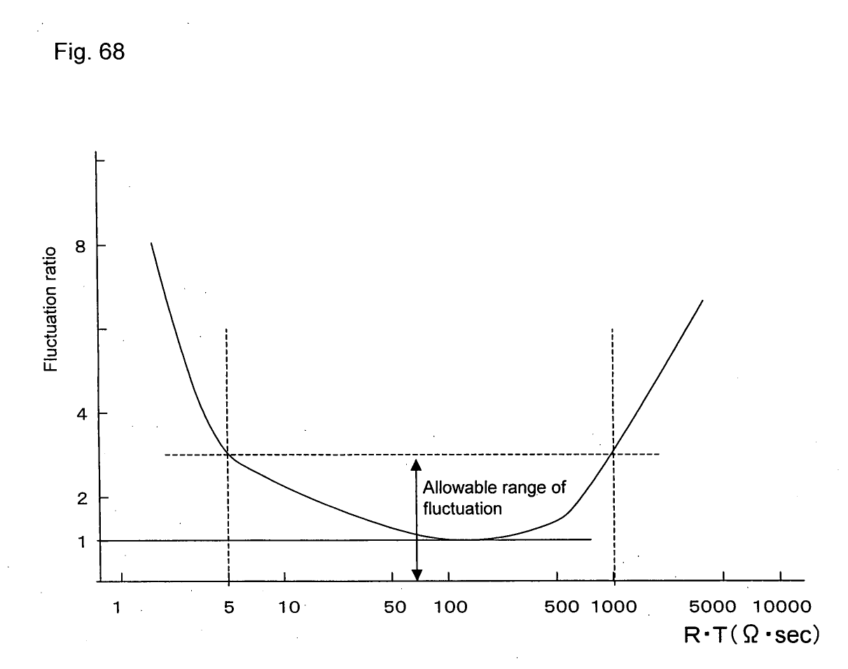

FIG. 67 illustrates relationship between IC voltage resistance and output variations of unit transistors 154. The variation rate on the vertical axis is based on the variation of unit transistors 154 produced in a 1.8-V voltage resistance process, which variation is taken to be 1.

FIG. 67 shows output variations of unit transistors 154 which were produced in various IC voltage resistance processes and have a shape of L/W=12/6 (μm) A plurality of unit transistors 154 were produced in each IC voltage resistance process and variations in their output current were determined. The voltage resistance processes were composed discretely of 1.8-V voltage resistance, 2.5-V voltage resistance, 3.3-V voltage resistance, 5-V voltage resistance, 8-V voltage resistance, and 10-V voltage resistance, 15-V voltage resistance processes. However, for ease of explanation, variations in the transistors formed in the different voltage resistance processes are plotted on the graph and connected with straight lines.

It is presumed that the correlation between the voltage resistance and output variations have something to do with the gate insulating film of the transistors. High voltage resistance results in a thick gate insulating film, which in turn results in low mobility, increasing variations in film thickness.

As can be seen from FIG. 67, the variation rate (variations in the output current of the unit transistors 154) increases gradually up until an IC voltage resistance of 13 V. However, when the IC voltage resistance exceeds 15 V, the slope of the variation rate with respect to the IC voltage resistance becomes large.

In FIG. 67, the permissible limit to the variation rate is 3 for 64- to 256-gradation display. The variation rate varies with the area, L/W, etc. of the unit transistor 154. However, the variation rate with respect to the IC voltage resistance is hardly affected by the shape of the unit transistor 154. The variation rate tends to increase above an IC voltage resistance of 13 to 15 V.

On the other hand, the potential at the output terminal 155 of the source driver circuit (IC) 14 varies with the programming current for the driver transistor 11a of the pixel 16. When the driver transistor 11a of the pixel 16 passes white raster (maximum white display) current, its gate terminal voltage is designated as Vw. When the driver transistor 11a of the pixel 16 passes black raster (completely black display) current, its gate terminal voltage is designated as Vb. The absolute value of Vw-Vb must be 2 V or larger. When the voltage Vw is applied to the output terminal 155, inter-channel voltage of the unit transistor 154 must be 0.5 V or higher.

Thus, a voltage of 0.5 V to ((Vw-Vb)+0.5) V is applied to the output terminal 155 (during current programming, the gate terminal voltage of the driver transistor 11a of the pixel 16 is applied to the terminal 155, which is connected with the source signal line 18). Since Vw-Vb equals 2 V, a voltage of up to 2 V+0.5 V=2.5 V is applied to the terminal 155. Thus, even if the output voltage (current) of the source driver IC 14 is a rail-to-rail output, an IC voltage resistance of 2.5 V is required. The amplitude required by an output terminal 155 is 2.5 V or more.

Thus, it is preferable to use a voltage resistance process in the range of 2.5-V to 15-V (both inclusive) for the source driver IC 14. More preferably, a voltage resistance process in the range of 3-V to 12-V (both inclusive) is used for the source driver IC 14. More preferably, minimum voltage resistance is 4.5 or higher from the viewpoint of relatively increasing the amplitude value of the driver transistor 11a and increasing variations in the gate terminal voltage of the driver transistor 11a with respect to the programming current, thereby improving programming accuracy. The IC voltage resistance is equivalent to the maximum value of available power supply voltage. Incidentally, the available power supply voltage is the voltage constantly available rather than instantaneous voltage resistance.

It has been described that a voltage resistance process in the range of 2.5-V to 13-V (both inclusive) is used for the source driver IC 12. This voltage resistance is also applied to examples (e.g., a low-temperature polysilicon process) in which the source driver circuit (IC) 14 is formed directly on an array board 30. Working voltage resistance of a source driver circuit (IC) 14 formed directly on an array board 30 can be high and exceeds 15 V in some cases. In such cases, the power supply voltage used for the source driver circuit (IC) 14 may be substituted with the IC voltage resistance illustrated in FIG. 67. Also, the source driver IC 14 may have the IC voltage resistance substituted with the power supply voltage used.

The reason why the unit transistors 154 must have a certain transistor size is that a wafer has a distribution of mobility characteristics.

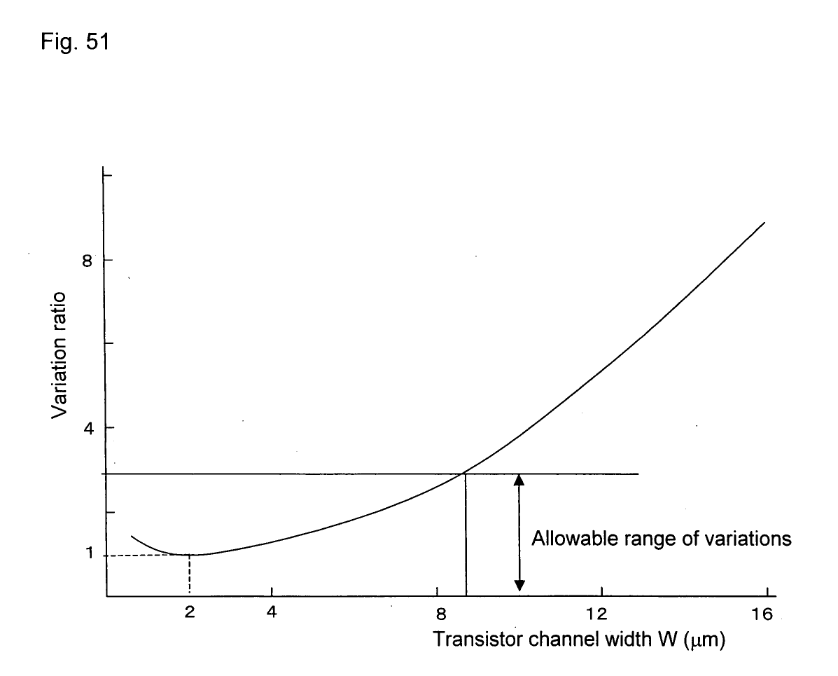

The channel width W of a unit transistor 154 is correlated with the variations in its output current. FIG. 51 is a graph obtained by varying the transistor width W of a unit transistor 154 with the area of the unit transistor 154 kept constant. In FIG. 51, the variation of the unit transistor 154 with a channel width W of 2 μm is taken as 1.

As can be seen from FIG. 51, the variation rate increases gradually when W of the unit transistor 484 is from 2 μm to 9 or 10 μm. The increase in the variation rate tends to become large when W is 10 μm or more. Also, the variation rate tends to increase when the channel width W=2 μm or less.

In FIG. 51, the permissible limit to the variation rate is 3 for 64- to 256-gradation display. The variation rate varies with the area of the unit transistor 154. However, the variation rate with respect to the IC voltage resistance is hardly affected by the area of the unit transistor 154.

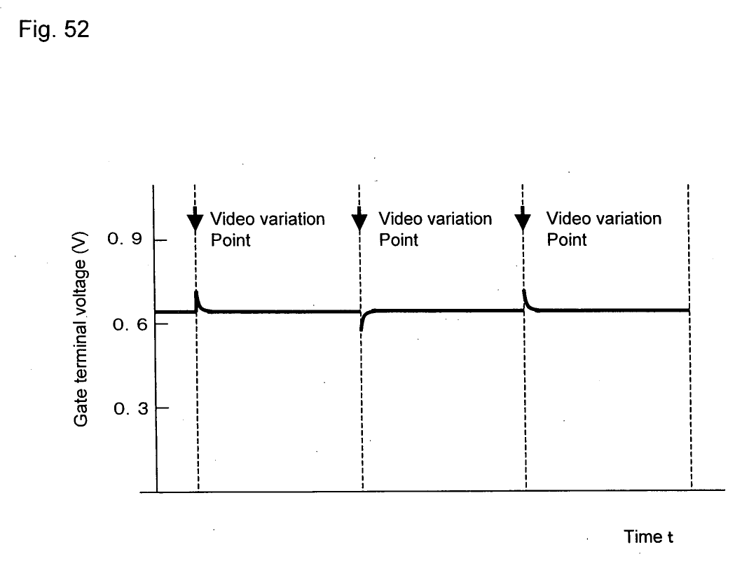

Thus, preferably, the channel width W of the unit transistor 484 is from 2 μm to 10 μm (both inclusive) More preferably, the channel width W of the unit transistor 154 is from 2 μm to 9 μm (both inclusive). Further, it is preferable that the channel width W of the unit transistors 154 falls within the above range in order to reduce linking of the gate wiring 153 in FIG. 52.

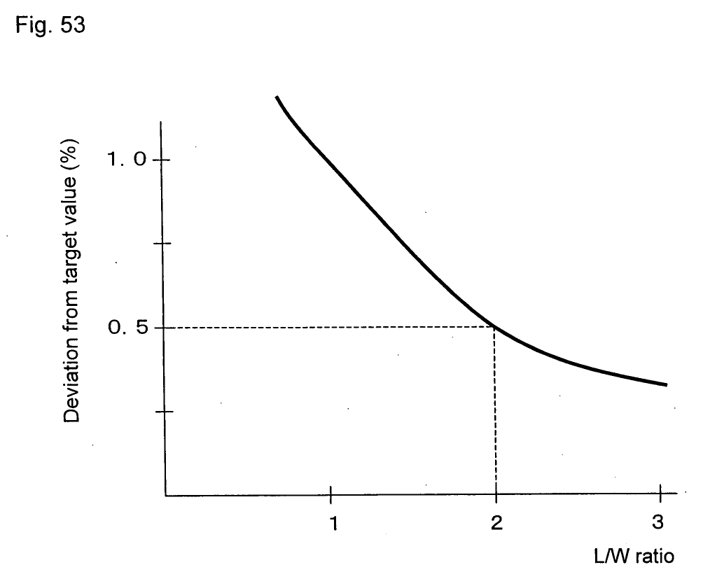

FIG. 53 is a graph showing deviation (variation) in L/W of unit transistors from a target value. When the L/W ratio of unit transistors 154 is equal to or smaller than 2, the deviation from the target value is large (the slope of the straight line is large). However, as L/W increases, the deviation from the target value tends to decrease. When L/W of unit transistors 154 is equal to or larger than 2, the deviation from the target value is small. Also, the deviation from the target value is 0.5% or less when L/W=2 or more. Thus, this value can be used for source driver circuits (IC) 14 to indicate accuracy of transistors.

In view of the above circumstances, it is preferable that L/W of a unit transistor 154 is two or more. However, larger L/W means larger L, and thus a larger transistor size. Thus, it is preferable that L/W is 40 or less. More preferably, L/W is between 3 and 12 (both inclusive).

The reason why a relatively large L/W value results in small output variations may be that when the gate voltage of the given unit transistor 154 is increased, variations in the output current are relatively small compared to variations in the gate voltage.

Besides, L/W also depends on the number of gradations. If the number of gradations is small, there is no problem even if there are variations in the output current of the unit transistor 154 due to kink effect because there are large differences between gradations. However, in the case of a display panel with a large number of gradations, since there are small differences between gradations, even small variations in the output current of the unit transistor 154 due to kink effect will decrease the number of gradations.

In view of the above circumstances, the driver circuit 14 according to the present invention is configured (constituted) to satisfy the following relationship:
(\sqrt{K/16}))≦L/W≦and (\sqrt{K/16}))×20
where K is the number of gradations, L is the channel length of the unit transistor 154, and W is the channel width of the unit transistor.

Although it has been stated as an example that 63 unit transistors 154 are arranged in each transistor group 431c to represent 64 gradations, the present invention is not limited to this. The unit transistor 154 may be further composed of a plurality of sub-transistors.

FIG. 547(a) shows the unit transistor 154. FIG. 547(b) shows a unit transistor 154 composed of four sub-transistors 5471. The output current by adding all the currents of a plurality of the sub-transistors 5471 is designed to be equal to that of the unit transistor 154. That is, the unit transistor 154 is composed of four sub-transistors 5471.

Incidentally, the present invention is not limited to a configuration in which the unit transistor 154 is composed of four sub-transistors 5471 and is applicable to any configuration in which the unit transistor 154 is composed of multiple sub-transistors 5471. However, the sub-transistors 5471 are designed to be of the same size or to produce the same output current.

In FIG. 547, reference character S denotes the source terminal of a transistor, G denotes the gate terminal of the transistor, and D denotes the drain terminal of the transistor. In FIG. 547(b), the sub-transistors 5471 are oriented in the same direction. In FIG. 547(c), the sub-transistors 5471 are oriented differently between different rows. In FIG. 547(d), the sub-transistors 5471 are oriented differently between different columns and arranged symmetrically about a point. All the arrangements in FIGS. 547(b), 547(c), and 547(d) have regularities.

FIGS. 547(a), 547(b), 547(c), and 547(d) show layouts. To form the unit transistor 154, the sub-transistors may be connected in series as illustrated in FIG. 547(e) or in parallel as illustrated in FIG. 547(f).

Changes in the formation direction of the unit transistors 154 or sub-transistors 5471 often change their characteristics. For example, in FIG. 547(c), the unit transistor 154a and sub-transistor 5471b produce different output currents even if an equal voltage is applied to their gate terminals. However, in FIG. 547(c), sub-transistors 5471 with different characteristics are formed in equal numbers. This reduces variations in the transistor (unit) as a whole. If the orientations of unit transistors 154 or sub-transistors 5471 with different formation directions are changed, differences in characteristics will complement each other, resulting in reduced variations in the transistor (single unit). Needless to say, the above items also apply to the arrangement in FIG. 547(d).

Thus, as illustrated in FIG. 548 and the like, by changing the orientations of unit transistors 154, it is possible to cause the characteristics of the unit transistors 154 formed in the vertical direction and the characteristics of the unit transistors 154 formed in the horizontal direction to complement each other in the transistor groups 431c as a whole, resulting in reduced variations in the transistor groups 431c as a whole.

FIG. 548 shows an example in which the unit transistors 154 are oriented differently between different columns within each transistor groups 431c. FIG. 549 shows an example in which the unit transistors 154 are oriented differently between different rows within each transistor groups 431c. FIG. 550 shows an example in which the unit transistors 154 are oriented differently between different rows as well as between different columns within each transistor group 431c.

There are less variations in characteristics among terminals 155 when the unit transistors 154 in the transistor group 431c are placed in a distributed manner as illustrated in FIG. 551(b) than when they are placed in an orderly manner as illustrated in FIG. 551(a). Incidentally, in FIG. 551, the unit transistors 154 hatched in the same manner form the transistor group 431c.

Variations in the characteristics of the unit transistors 154 also depend on the output current of the transistor group 431c. The output current in turn depends on the efficiency of the EL elements 15. For example, the programming current outputted from the output terminal 155 for the G color decreases with increases in the luminous efficiency of the EL elements 15 for the G color. Conversely, the programming current outputted from the output terminal 155 for the B color increases with decreases in the luminous efficiency of the EL elements 15 for the B color.

The decreased programming current means decreases in the current outputted by the unit transistors 154. The decreased current results in increased variations in the unit transistors 154. To reduce the variations in the unit transistors 154, the transistor size can be increased.

FIG. 552 shows an example. In FIG. 552, the output current of the R pixels is the smallest, and thus the size of the unit transistors 154 for the R pixels is the largest. On the other hand, the output current of the G pixels is the largest, and thus the size of the unit transistors 154 for the G pixels is the smallest. The output current of the B pixels is intermediate in magnitude. The size of the unit transistors 154 for the B pixels is intermediate between the R pixels and B pixels. Thus, it is very useful to determine the size of the unit transistors 154 according to the efficiency of the EL elements for R, G, and B colors (according to the magnitude of programming current).

It has been stated herein that a plurality of unit transistors 154 are formed or placed for each bit (excluding the least significant bit) as illustrated in FIG. 553(b). However, the present invention is not limited to this. Needless to say, for example, one transistor 154 may be formed or placed for each bit to output a current appropriate to the given bit as illustrated in FIG. 553.

It has been stated that 63 unit transistors 154 are formed in the case of 64 gradations (6 bits each for R, G, and B). It follows that 255 unit transistors 154 are required in the case of 256 gradations (8 bits each for R, G, and B).

Current programming has a peculiar advantage of allowing addition of currents. Also, it provides a peculiar advantage of being able to halve the current flowing through a unit transistor 154 by reducing the channel width W of the unit transistor 154 to ½ with its channel length L kept constant. In the same way, it provides a peculiar advantage of being able to reduce the current flowing into ¼ by reducing the channel width W of the unit transistor 154 to ¼ with its channel length L kept constant.

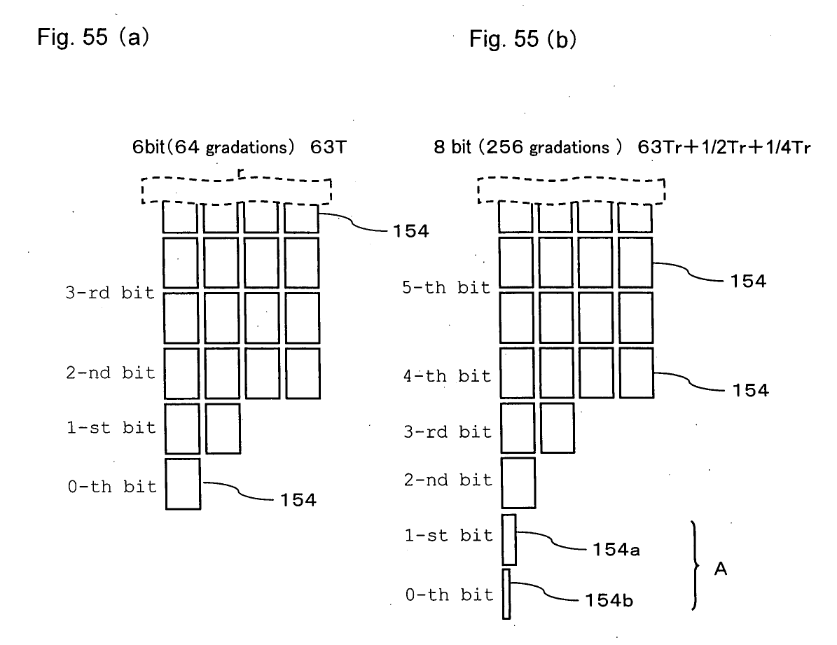

FIG. 55(b) shows a configuration of a transistor group 431c in which unit transistors 154 of the same size are placed for all bits. For ease of explanation, it is assumed that in FIG. 55(a) 63 unit transistors 154 are formed to compose the 6-bit transistor group 431c. Also, it is assumed that shown in FIG. 55(b) is an 8-bit transistor group.

In FIG. 55(b), low-order two bits (indicated by A) consist of transistors smaller in size than the unit transistors 154. The least significant bit, i.e., the 0-th bit consists of a transistor (shown as unit transistor 154b) with a channel width ¼ the channel width W of the unit transistors 154. The 1-st bit consists of a transistor (shown as unit transistor 154a) with a channel width ½ the channel width W of the unit transistors 154.

In this way, the low-order two bits consist of transistors (154a and 154b) smaller in size than the higher-order unit transistors 154. The number of regular unit transistors 154 is 63, which remains unchanged. Thus, even if a 6-bit configuration is changed to an 8-bit configuration, there is not much difference in the formation area of the transistor group 431c between FIG. 55(a) and FIG. 55(b).

The size of the transistor group 431c in the output stage does not increase even if 6-bit specification is changed to 8-bit specification as illustrated in FIG. 55(b) because this example takes advantage of the facts that currents can be added and that the current passed through the unit transistors 154 can be reduced to 1/n by reducing the channel width W of the unit transistors 154 to 1/n with its channel length L kept constant.

Also, as illustrated in FIG. 55(b), unit transistors (e.g., 154a and 154b) of smaller size increase variations in output current. However, no matter how large variations may be, the output current of the unit transistor 154a or 154b is added. Thus, the 8-bit specification in FIG. 55(b) can produce a higher gradation output than the 6-bit specification in FIG. 55(a). Of course, there is a possibility that accurate 8-bit display cannot be achieved because of the large output variations of the unit transistors 154a and 154b. However, it is sure that higher-resolution display can be achieved than in FIG. 55(a).

Actually, however, the output current is not reduced exactly to ½ even if the channel width W is halved. Some corrections are necessary. Results of study show that the output current is reduced to less than ½ when the channel width W is halved with the gate terminal voltage kept constant. Thus, when using transistors of different sizes for low-order bits and high-order bits, the present invention sets the transistor sizes as follows.

A small number of sizes such as two sizes are used for the unit transistors 154 in the source driver circuit (IC) 14. The plurality of unit transistors 154 have the same channel length L. That is, only the channel width W is varied. If the ratio between a first unit output of a first unit transistor and second unit output of a second unit transistor is n (first unit output : second unit output=1:n), the following relationship should be satisfied: the channel width W1 of the first unit transistor<the channel width W2 of the second unit transistor W2×n×a (where a=1).

If W1×n×a=W2, preferably the relationship 1.05<a<1.3 is satisfied. Regarding the correction a, a correction factor can be determined easily by forming and measuring test transistors.

To create (configure) low-order bits, the present invention places or forms unit transistors smaller than the unit transistors 154 for high-order bits. The term “smaller” here means being smaller in terms of the output current of the unit transistors. Thus, the smaller unit transistors include not only unit transistors smaller in channel width W than the unit transistor 154, but also unit transistors smaller in both channel width W and channel length L. They also include unit transistors of other shapes.

In FIG. 55, the unit transistors 154 composing the transistor group 431c come in multiple sizes: namely two sizes. This is because if the unit transistors 154 vary in size, the magnitude of their output current is no longer proportional to the transistor shape as described above, resulting in design difficulty. Thus, it is preferable to use two sizes—for low gradations and high gradations—for the unit transistors 154 composing the transistor group 431c. However, the present invention is not limited to this. Needless to say, three or more sizes may be used.

As also illustrated in FIG. 43, the gate terminals of the unit transistors 154 composing the transistor group 431c are connected to a single gate wire 153. The output currents of the unit transistors 154 depend on the voltage applied to the gate wire 153. Thus, if the unit transistors 154 in the transistor group 431c have the same shape, the unit transistors 154 output equal unit currents.

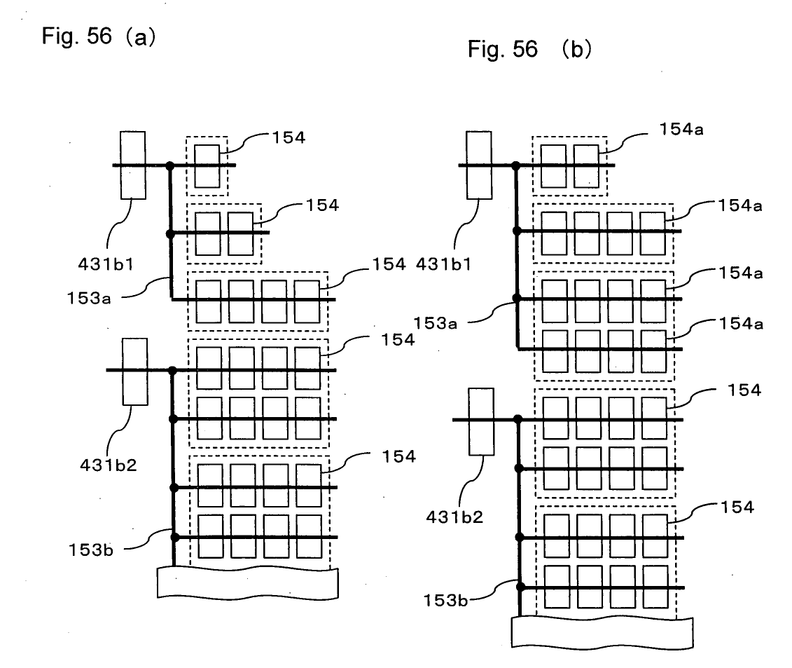

The present invention is not limited to sharing the gate wiring 153 among the unit transistors 154 composing the transistor group 431c. For example, the configuration in FIG. 56(a) may be used. FIG. 56(a) shows the unit transistors 154 which compose current mirror circuits in conjunction with the transistor 158b1 as well as unit transistors 154 which compose current mirror circuits in conjunction with the transistor 158b2.

The transistor 158b1 is connected to the gate wiring 153a while the transistor 158b2 is connected to the gate wiring 153b. In FIG. 56(a), the uppermost one unit transistor 154 corresponds to the LSB (0-th bit), the two unit transistors 154 in the second row correspond to the 1-st bit, the four unit transistors 154 in the third row correspond to the 2-nd bit, and the eight unit transistors 154 in the third row correspond to the 3-rd bit.

In FIG. 56(a), by applying different voltages to the gate wiring 153a and gate wiring 153b, it is possible to vary the output current among the unit transistors 154 even if the unit transistors 154 have the same size and shape.

Although it has been stated that different voltages are applied to the gate wiring 153a and gate wiring 153b while using unit transistors 154 of the same size and the like, the present invention is not limited to this. Unit transistors 154 of different shapes may be made to produce equal output currents by adjusting the voltages applied to the gate wiring 153a and gate wiring 153b.

In FIG. 55, the size of the unit transistors 154 constituting low-gradation bits are smaller than the unit transistors 154 constituting high-gradation bits. Decreases in the size of the unit transistors 154 increase output variations. To reduce the output variations by avoiding decreases in the area of the low-gradation unit transistors 154, the unit transistors 154 for low gradations actually have a longer channel length L than the unit transistors 154 for high gradations.

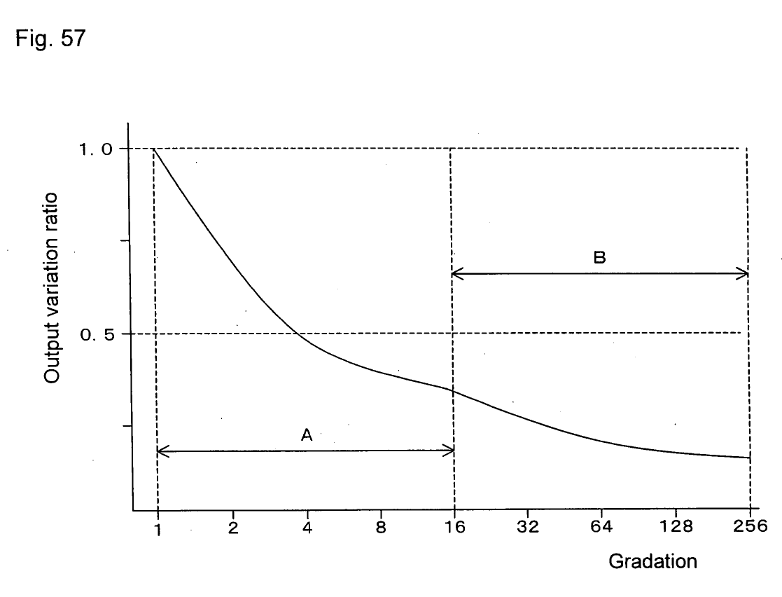

As illustrated in FIG. 57, if the size of the unit transistors 154 are varied between a low gradation region A and high gradation region B, the output variations are expressed by a combination of two curves. However, there is no practical problem. Conversely, this is preferable because by making the low-gradation unit transistors 154 larger in size than the high-gradation unit transistors 154, it is possible to reduce the output variations per unit transistor 154.

The configuration in FIG. 56 makes it possible to equalize the output currents of the unit transistors 154 by adjusting the voltages applied to the gate wiring 153 regardless of the sizes of the low-gradation and high-gradation unit transistors 154.

Although two gate wires 153—namely 153a and 153b—have been described herein, there may be three or more gate wires. Also, there may be three or more shapes of unit transistors 154.

FIG. 56(b) shows an example in which two gate wires 153 are used and the unit transistors 154 have the same size. In FIG. 56(b), the uppermost two unit transistors 154 correspond to the LSB (0-th bit), the four unit transistors 154 in the second row correspond to the 1-st bit, and the eight unit transistors 154 in the third row correspond to the 2-nd bit. The eight unit transistors 154 located in the fourth row and connected to the gate wiring 153b correspond to the 3-rd bit.

In FIG. 56(b), by applying different voltages to the gate wiring 153a and gate wiring 153b, it is possible to vary the output current among the unit transistors 154 even if the unit transistors 154 have the same size and shape.

In FIG. 56(b), the output current of each unit transistor 154a connected to the gate wiring 153a for high gradations is configured to be ½ the output current of each unit transistor 154b connected to the gate wiring 153b for low gradations. The unit transistors 154a and unit transistors 154b have the same shape.

To reduce the output current of the unit transistors. 154a to ½ the output current of the unit transistors 154, a lower voltage is applied to the gate wiring 153a than to the gate wiring 153b. Adjustment of the voltages applied to the gate wiring 153 makes it possible to vary or adjust the output currents even if the unit transistors 154a and unit transistors 154 have approximately the same shape.

In the example in FIG. 56, it has been stated that the voltages applied to the gate wiring 153 are varied. Needless to say, the voltages may be applied to the gate wiring 153 from outside the source driver circuit (IC) 14. Generally, however, the voltages applied to the gate wiring 153 can be adjusted or changed by changing or designing the configuration or size of the transistors 158b (transistor group 431b) which compose current mirrors in conjunction with the unit transistors 154. Needless to say, it is possible to change or adjust the current Ic passed through the transistors 158b (transistor group 431b) which compose current mirrors in conjunction with the unit transistors 154.

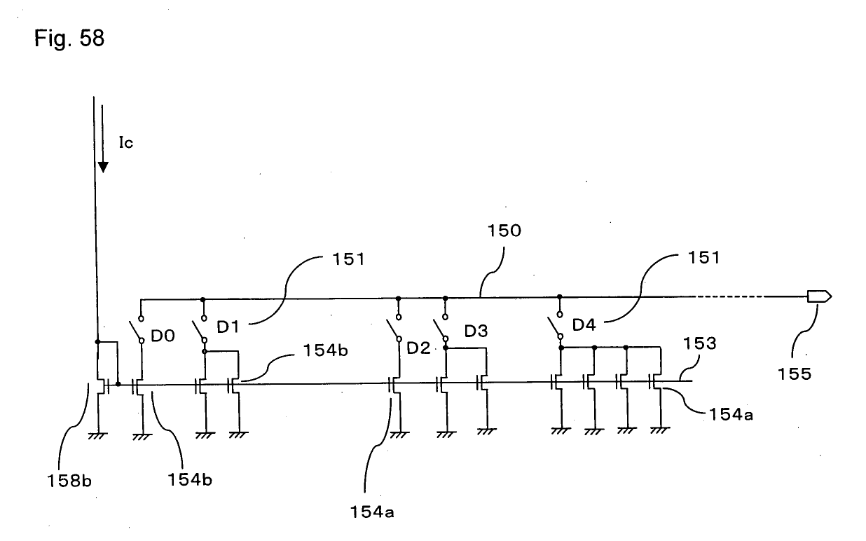

In FIG. 58, the numbers of unit transistors 154a (D2, D3, D4, . . . ) for high gradations are powers of two. The numbers of unit transistors 154b (D1, D2) for low gradations are also powers of two when the numbers of the unit transistors themselves are counted. If each unit transistor is composed of sub-transistors, the number of sub-transistors is an integral multiple of the number of unit transistors.

Unit output currents are varied between the unit transistors 154a and unit transistors 154b (The unit transistors 154b produce a smaller unit current than the unit transistors 154a. For example, the low-gradation unit transistors have a smaller channel width W). Both low-gradation unit transistors 154 and high-gradation unit transistors 154 are connected to common gate wiring 153 and are controlled by a reference current Ic flowing through the transistors 158b of a current mirror circuit.

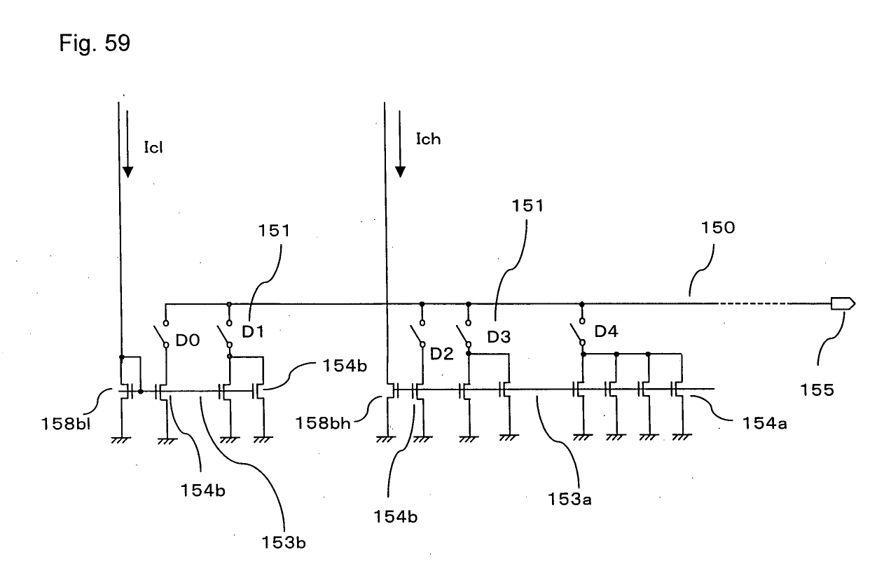

In FIG. 59, the numbers of unit transistors 154a (D2, D3, D4, . . . ) for high gradations are powers of two. The numbers of unit transistors 154b (D1, D2) for low gradations are also powers of two when the numbers of the unit transistors themselves are counted. The high-gradation unit transistors 154a compose a current mirror circuit in conjunction with the transistor 158bh. A reference current Ich flows through the transistor 158bh. On the other hand, the low-gradation unit transistors 154b compose a current mirror circuit in conjunction with the transistor 158bl. A reference current Icl flows through the transistor 158bl.

The above configuration makes the unit transistors 154a and unit transistors 154b produce different unit output currents (The unit transistors 154b produce a smaller unit current than the unit transistors 154a). The low-gradation unit transistors 154 and high-gradation unit transistors 154 are connected to different gate wires 153.

As can be seen from the above description, the present invention has many variations. For example, a combination of configurations in FIGS. 58 and 59 is conceivable. Needless to say, the above items also apply to other examples of the present invention. Also, part of the unit transistors 154 may be larger or smaller.

Preferably, the unit transistors 154 composing the transistor group 431c and transistors 158b composing the transistor group 431b are N-channel transistors. This is because N-channel transistors produce smaller output variations per unit transistor area than P-channel transistors. Thus, by using N-channel transistors for the unit transistors 154 and the like, it is possible to reduce the size of the source driver IC.

Incidentally, the use of N-channel transistors for the unit transistors 154 means a sink type (sink current type) source driver IC 14. Thus, it is preferable that the driver transistors 11a of the pixels 16 are P-channel transistors.

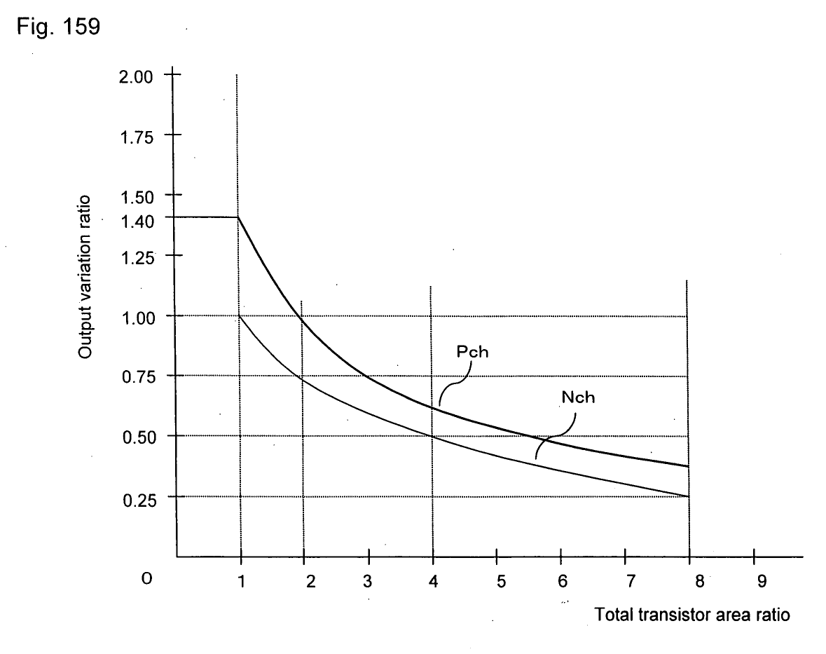

FIG. 159 is a graph showing output variations assuming that P-channel transistors and N-channel transistors are equal in size (WL) and output current. The horizontal axis represents the total area Sc (in terms of area ratio) of the transistor group 431c which provides one output. The larger the area Sc, the smaller the output variations.

The vertical axis in FIG. 159 represents an output variation ratio, which is taken as 1 when the total area Sc of the N-channel transistors is 1.

As illustrated in FIG. 159, when the total area Sc of the N-channel transistors is increased 4 times, the output variation becomes 0.5. When the total area Sc of the N-channel transistors is increased 8 times, the output variation becomes 0.25. That is, results provided by the present invention indicate that the output variation is proportional to 1/√Sc.

When the total area Sc of N-channel transistors and total area Sc of P-channel transistors are equal, the output variation of the P-channel transistors is 1.4 times the output variation of the N-channel transistors. When the total area Sc of the P-channel transistors is twice the total area Sc of the N-channel transistors, their output variations are equal. That is, N-channel transistors and P-channel transistors have equal output variations when the total area Sc of the N-channel transistors/2=the total area Sc of the P-channel transistors.

Thus, it is preferable that the unit transistors 154 composing the transistor group 431c and transistors 158b composing the transistor group 431b are composed (formed) of N-channel transistors.

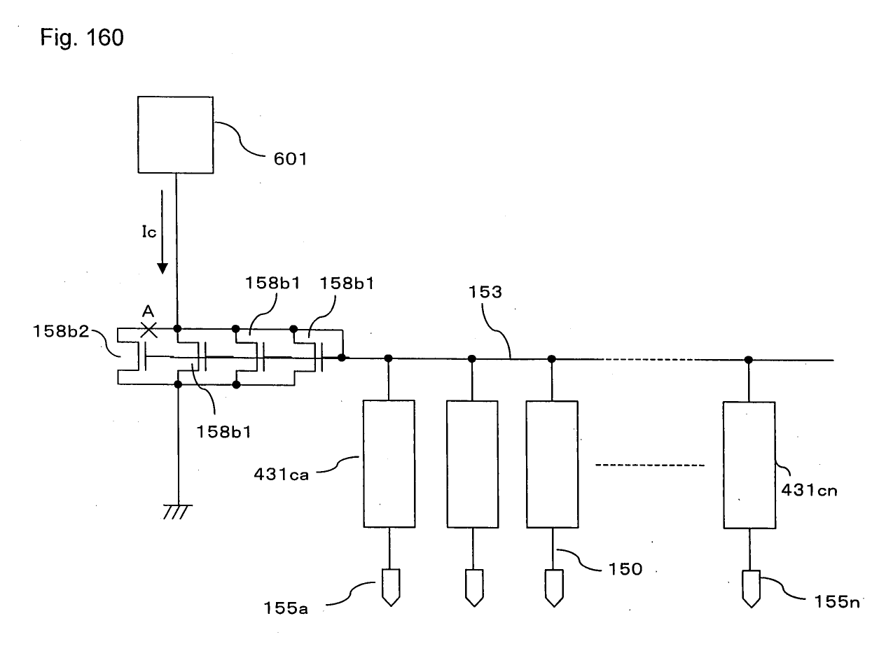

An output stage is composed of unit transistors 154 and the like. The transistor group 431c composes current mirror circuits in conjunction with transistors 158b or with a transistor group consisting of transistors 158b. If the unit transistors 154c and transistors 158b are placed in close vicinity, an almost constant current mirror ratio is obtained. However, the current mirror ratio sometimes fluctuates in a certain range. In that case, it is useful to cut off the transistor 158b or the like by trimming (laser trimming, sand blasting, etc.) as illustrated in FIG. 160 so that the current mirror ratio will fall within a predetermined range.

The trimming is performed at point A in FIG. 160 to cut off the transistor 158b2. By forming a large number of transistors 158b and cutting off two or more of them, it is possible to increase the current mirror ratio.

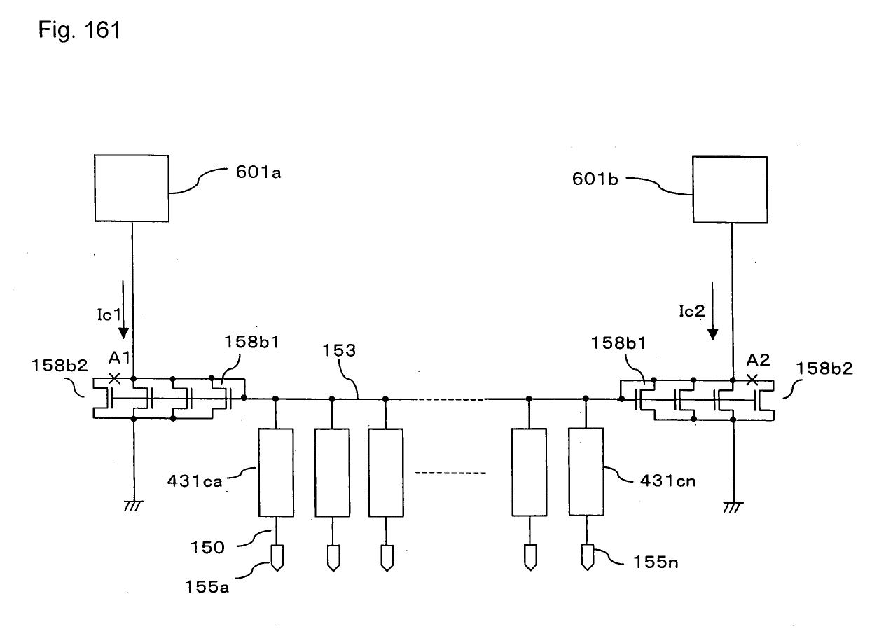

Preferably, as shown in FIG. 161, transistors 158b are formed or placed at both ends of wiring 153. By cutting at trimming point A1 or A2, it is possible to average the output currents from output terminals 155a and 155n of the IC chip.

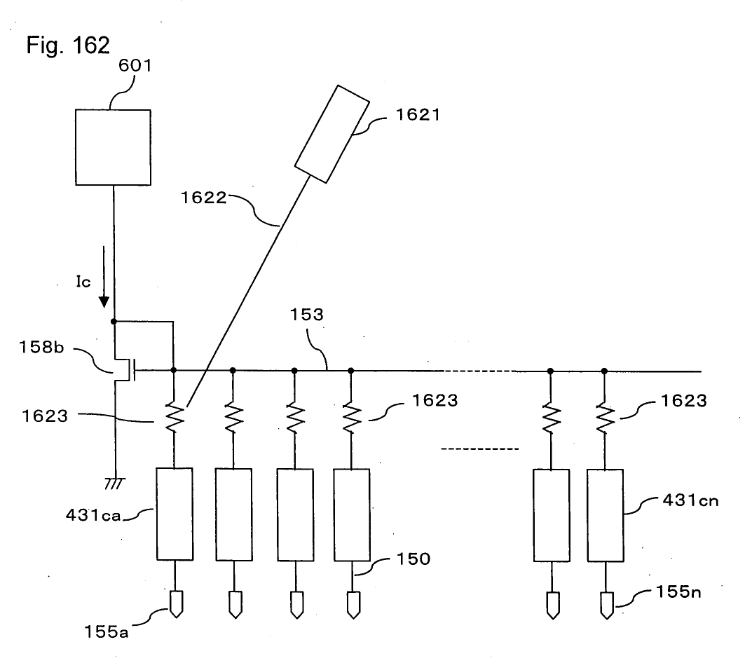

The configuration in FIG. 162 is effective in adjusting output variations of transistors 431c in output stages. In FIG. 162, high-value resistor 1623 is formed or placed between each transistor group 431c and the gate wiring 153. (It is not limited to transistor groups. Current output circuits of any configuration may be used.) Because of its high value, the resistor 1623 causes voltage drops even if the output current from the output stage is very weak. The voltage drops allow the output current to be adjusted.

The resistor 1623 is trimmed using a laser light 1622 from a trimmer 1621. The resistor 1623 is trimmed to raise its resistance.

Incidentally, although the transistor group 431c is composed of unit transistors 154 according to examples of the present invention, this is not restrictive. A single transistor or a current-holding circuit (described later) may be used alternatively. Also, a voltage-current conversion (V-I conversion) circuit may be used. That is, although it is stated herein that output stages are constituted of transistor groups 431c, this is not restrictive. Current output circuits of any configuration may be used.

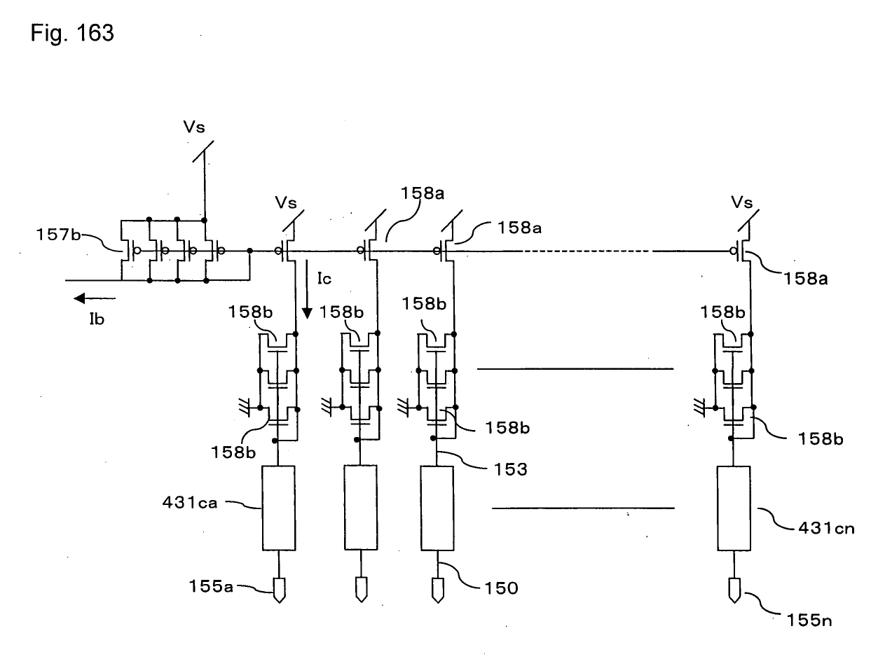

In FIG. 163, a transistor 157b composes a current mirror circuit in conjunction with a plurality of transistors 158a, which in turn compose current mirror circuits in conjunction with transistors 158b. Furthermore, the transistors 158b compose current mirror circuits in conjunction with transistors 431c.

The configuration shown in FIG. 163 constitutes a part of the present invention. Adjustment by trimming can be performed on the transistor 158b or transistor group 431c in each output stage.

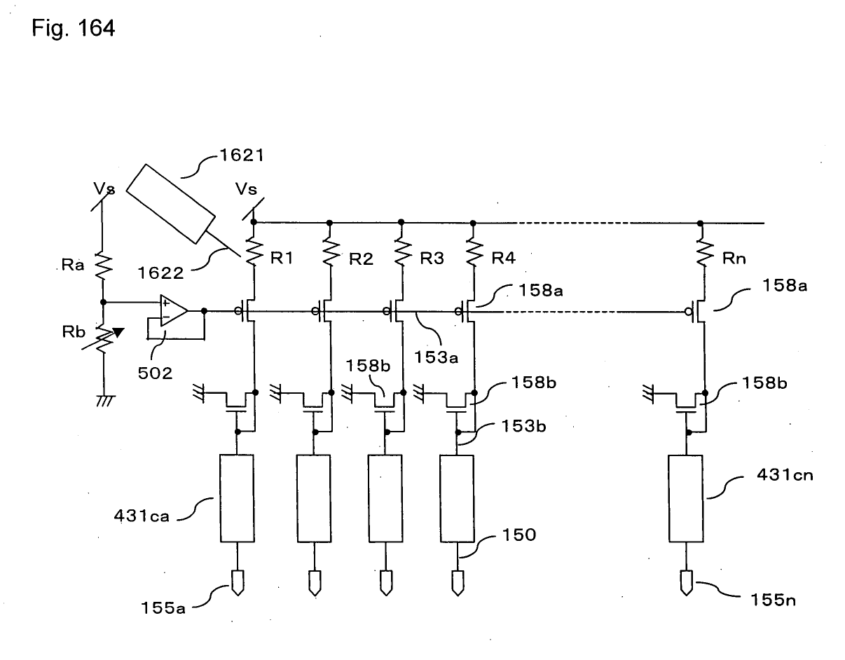

Other possible configurations include the one shown in FIG. 164. FIG. 164 conceptually shows output stages of the source driver IC according to the present invention. The potential of the gate wiring 153a is determined (adjusted) based on the reference voltage (or power supply voltage of the IC (circuit) 14) Vs and external resistors Ra and Rb.

The current circuit in each output stage consists of a resistor Rn and transistors 158a and 158b. The current flowing through the current circuit depends on the resistor Rn. The transistor 158b and transistor group 431c compose a current mirror circuit. The current outputted from an output terminal 155 of the transistor group 431c is obtained by trimming the resistor Rn. By laser-trimming the resistor Rn, it is possible to control the current flowing through the current mirror circuit (transistor 158b and transistor group 431c). Of course, the transistors 158a and 158b may compose a transistor group.

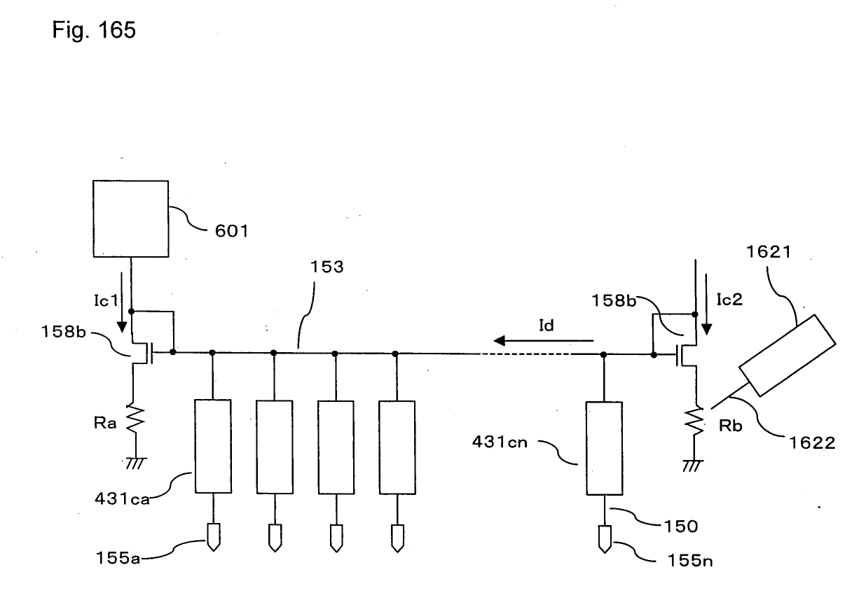

The configuration in FIG. 165 is also effective in adjusting the slopes of output currents on the left and right sides of the IC chip (equalizing the output terminals 155a to 155n, i.e., eliminating output variations). A resistor Ra is placed on a current Ic1 path of a transistor 158b and a resistor Rb is placed on a current Ic2 path of a transistor 158b. The resistor Ra and resistor Rb may be installed either internally or externally. By trimming one or both of Ra and Rb, it is possible to vary the current Id flowing through the gate wiring 153. Thus, voltage drops in the gate wiring 153 cause the potential of the gate signal line for the unit transistors 154 in the output stage 431 to vary. This makes it possible to correct the slope distribution of output currents in the output stages 431a to 431n.

The concept of trimming includes adjustment. For example, in FIG. 165, the resistors Ra and Rb may be formed (placed) as regulators. The magnitude of a current Id can be adjusted by adjusting the regulators. If resistors are diffused resistors, their resistance can be adjusted or varied by heating. For example, the resistance can be adjusted by irradiating the resistors with a laser light and thereby heating them. Also, by heating the IC chip entirely or partially, it is possible to adjust or vary the overall resistance in the IC chip or the resistance of some resistors.

Needless to say, the above items also apply to other examples of the present invention. Also, trimming includes element trimming which varies resistance; functional trimming which varies functions; cutting which cuts off elements such as transistors from wiring; splitting which divides one resistive element into multiple parts; trimming which involves irradiating unconnected parts with a laser light, short-circuiting them, and thereby connecting them; adjustment which adjusts resistance of regulators and the like. In the case of transistors, trimming also includes varying the S value, varying μ, varying the WL ratio and thereby varying the magnitude of output current, and changing the position of rising voltage. Besides, it includes varying oscillation frequency and varying cutoff positions. In short, the concept of trimming includes concepts of processing, adjustment, and changing. The above items are also true to other examples of the present invention.

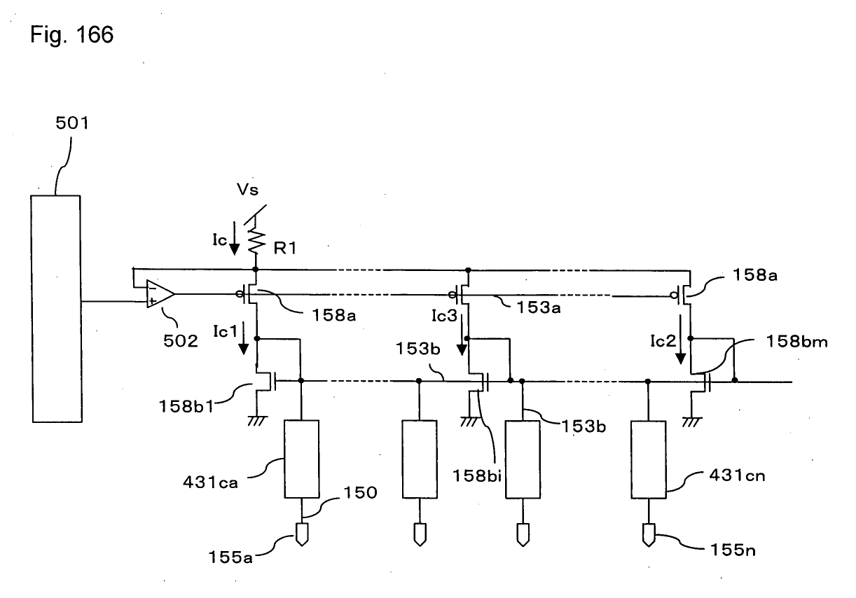

Other possible configurations include the one shown in FIG. 166. FIG. 166 conceptually shows output stages of the source driver IC according to the present invention. The potential of the gate wiring 152a is determined (adjusted) by the electronic regulator circuit 501 and operational amplifier 502. A constant current circuit is composed of the operational amplifier 502, resistor R1, and transistor 158a. A reference current Ic flows through R1. The value of the current flowing through R1 depends on the voltage applied to the positive terminal of the operational amplifier 502 and the resistance of the resistor R1.

Thus, the magnitude of the reference current Ic can be varied by trimming the resistor R1. This makes it possible to change or adjust the magnitude of the output current from the output terminal 155. The resistor RI may be a regulator installed externally. Alternatively, it may be an electronic regulator circuit. Also, it may be provided as an analog input.

The output current from the operational amplifier 502 is applied to the gate terminals of a plurality of transistors 158a. Consequently, a current Ic flows through the resistor R1. The current Ic is divided and passed through the transistors 158b. This current sets the gate wiring 153b to a predetermined potential. The potential of the gate wiring 153b is fixed by the transistors 158b placed at a plurality of locations. This makes the gate wiring 153bless liable to potential gradient and reduces output variations of the output terminals 155.

In the above example, unit transistors 154 are formed corresponding to gradation bits as illustrated in FIG. 43 and the output current is varied by varying the number of unit transistors 154 which are turned on (to output current to the terminal 155). For example, in FIG. 43, thirty-two (32) unit transistors 154 are placed for the D5 bit, one unit transistor 154 is placed (formed) for the D0 bit, and two unit transistors 154 are placed (formed) for the D1 bit.

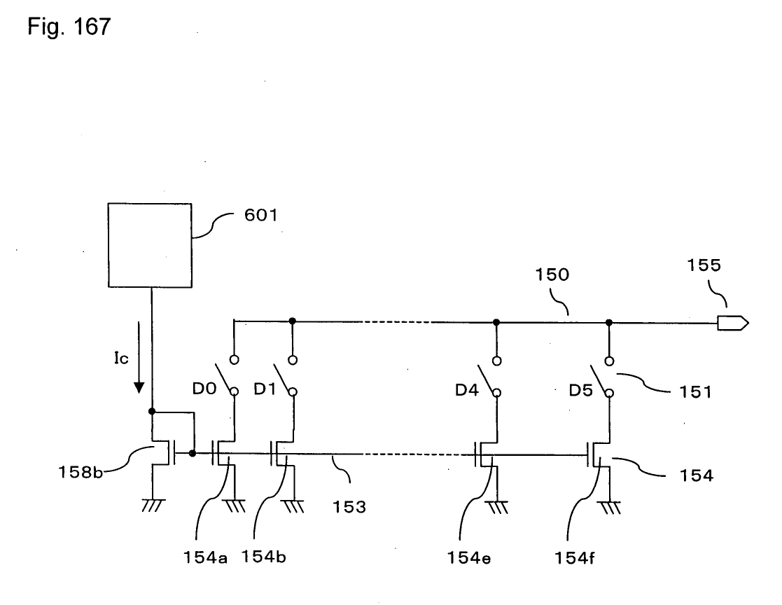

However, the present invention is not limited to this. For example, as illustrated in FIG. 167, different bits may be represented by transistors of different sizes. In FIG. 167, the transistor 154b outputs a current approximately two times larger than the transistor 154a and the transistor 154f outputs a current approximately two times larger than the transistor 154e. Thus, the present invention is not limited to configurations in which the output stage 431c is composed of unit transistors 154.

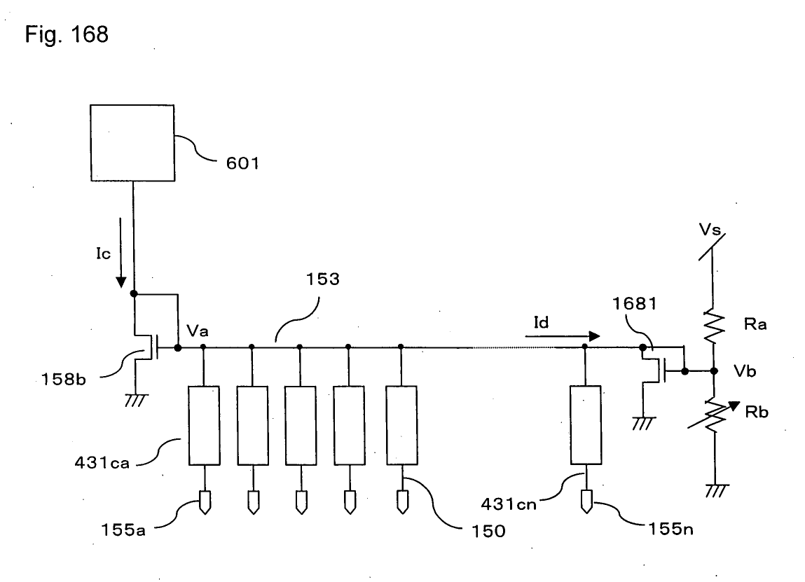

FIG. 165 shows a configuration in which both ends of the gate wiring 153 is held by transistors 158b while FIG. 166 shows a configuration in which the potential of the gate wiring 153 is held by a plurality of transistors 158b. The present invention is not limited to this. For example, as illustrated in FIG. 168, the potential gradient of the gate wiring 153 may be adjusted by the current Id flowing through a transistor 1681 with one end of the gate wiring 153 held by the transistor 1681. The current flowing through the transistor 1681 is adjusted by divided voltages of the resistors Ra and Rb connected to the gate terminal. The resistor Rb is configured as a regulator or its resistance is adjusted by trimming. Basically, the current flowing through the transistor 1681 is very weak.

However, special operating methods include, for example, a method which lowers the potential of the gate wiring 153 close to ground potential by making the transistor 1681 perfect. By lowering the potential of the gate wiring 153 close to ground potential, the unit transistors 154 in the transistor group 431c can be turned off. That is, the output current of the output terminal 155 can be turned on and off through operation of the transistor 1681.

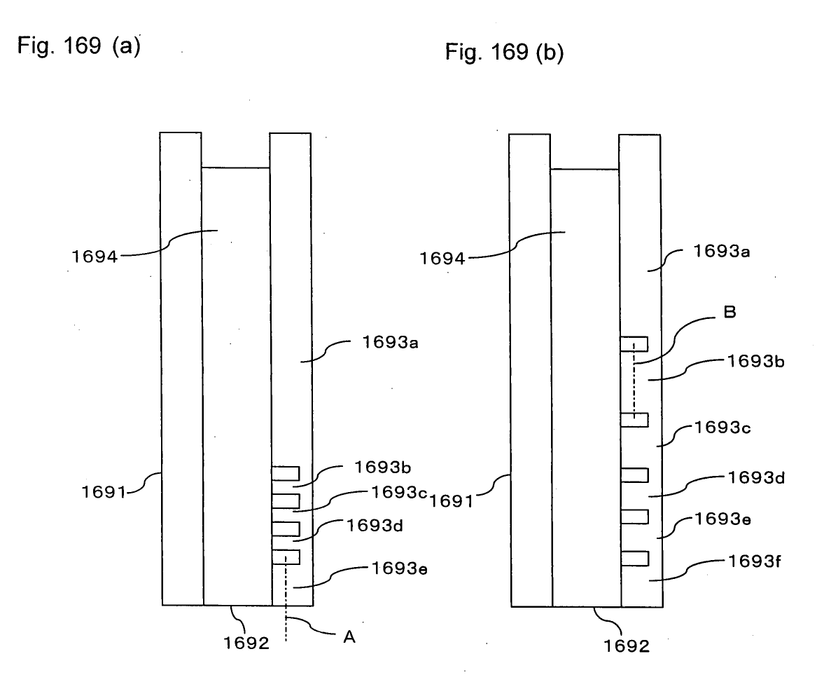

In the above example, the output current and the like can be varied, changed, or adjusted by trimming or adjusting transistors (158, 154, etc.). Specifically, the transistors to be adjusted, etc. are preferably configured as illustrated in FIG. 169. FIG. 169 conceptually shows a transistor 1694 to be adjusted, etc. The transistor 1694 has a gate terminal 1692, source terminal 1691, and drain terminal 1693. The drain terminal 1693 is divided into multiple parts (drain terminals 1693a, 1693b, 1693c, . . . ) to ease trimming. A cut along line A in FIG. 169(a) cuts off the drain terminal 1693e, decreasing the output current of the transistor 1693.

FIG. 169(a) shows the transistor 1694 with trimming intervals of the drain terminal 1693 varied. Depending on the amount of current to be trimmed, one or more drain terminals 1693 are trimmed to adjust the output current. In FIG. 169(a), drain terminals are trimmed along line B.

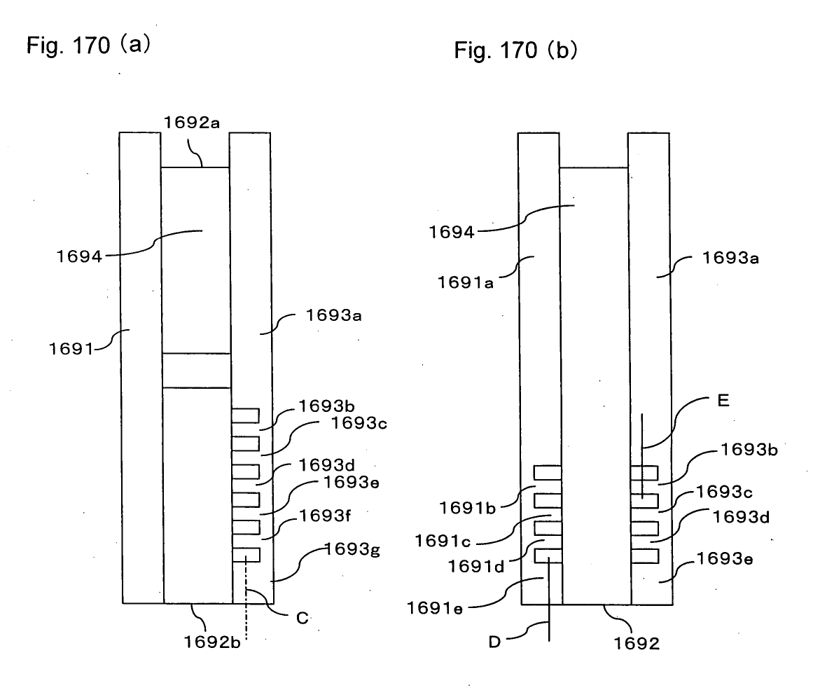

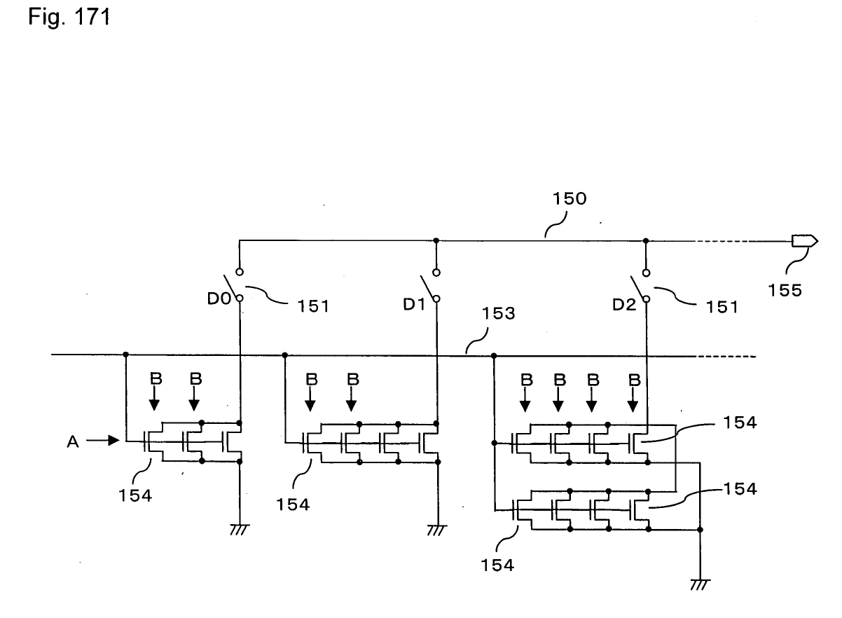

FIG. 170 shows a variation of FIG. 169. FIG. 170(a) shows an example in which the gate terminal 1692 is divided into 1692a and 1692b. FIG. 170(b) shows an example in which the drain terminal 1693 and source terminal 1691 are provided with trimming lines (line C, line D).

The trimming methods in FIGS. 168, 170, etc., in particular, are effective for elements (transistors and the like) which are cascaded. This is because the magnitude of current delivered via a cascade connection can be adjusted by trimming, resulting in a good cascade connection. The above items also apply to other examples of the present invention.

Although in the above example, the drain terminal 1693 or source terminal 1691 is trimmed at one or more locations, the present invention is not limited to this. For example, the gate terminal 1692 may be trimmed. The present invention is not limited to trimming. Needless to say, it is alternatively possible to direct a laser light or thermal energy at a semiconductor film of the transistor 1694, thereby degrade the transistor 1694, and thereby adjust output current. Also, the examples in FIGS. 169, 170, etc. are not limited to transistors. Needless to say, they are also applicable to diodes, quartz, thyristors, capacitors, resistors, or the like.

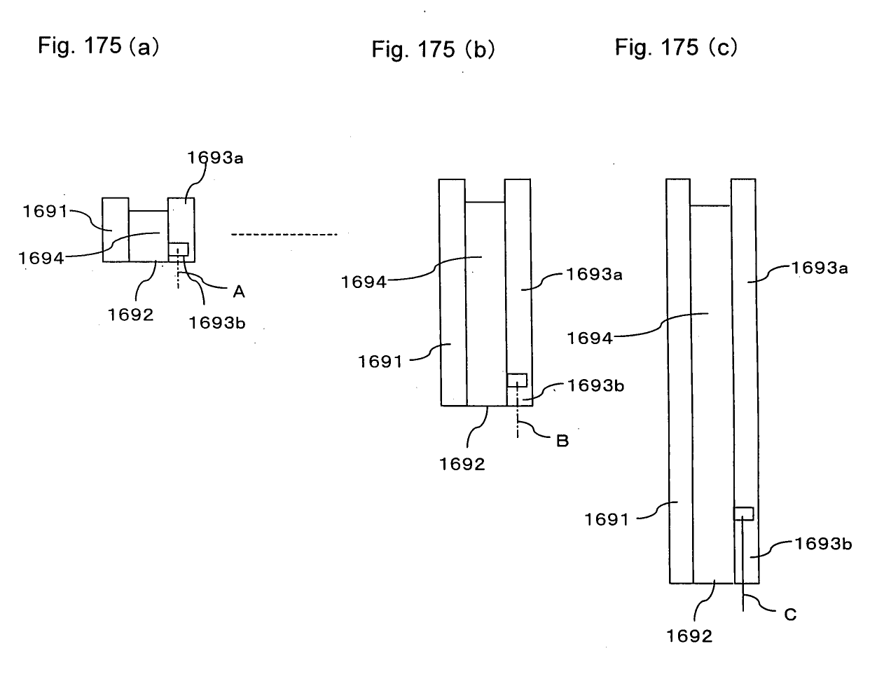

As illustrated in FIG. 167, if transistor size varies among different bits (e.g., if the transistor size is proportional to bit size), preferably the length (e.g., the length of the drain terminal) to be trimmed is proportional to bit size. An example is shown in FIGS. 175(a), 175(b), and 175(c).

In FIGS. 175(a), 175(b), and 175(c), FIG. 175(a) corresponds to low-order bits and 175(c) corresponds to high-order bits. FIG. 175(b) corresponds to intermediate bits between FIGS. 175(a) and 175(c). Trimming length A for the low-order bits are configured to be shorter than trimming length C for the high-order bits. Trimming length is proportional to the amount of change in transistor current. Thus, the amount of trimming is larger in the case of transistors for high-order bits. As can be seen from the above description, it goes without saying that the trimming length may be varied according to transistor size, bit positions, etc. That is, there is no need to make transistor size uniforms among different bits.

FIG. 43 shows an example in which the required number of unit transistors 154 are formed or placed for each bit. However, unit transistors 154 are subject to manufacturing variations, causing variations in the output from the output terminal 155. To reduce the variations, it is necessary to adjust the output current of each bit. To adjust the output current, extra unit transistors 154 can be formed in advance and cut off from the output terminal 155. Incidentally, the extra unit transistors 154 do not need to have the same size as the other unit transistors 154. Preferably, the extra unit transistors 154 are smaller in size (so that they will share smaller part of the output current).

FIG. 171 shows an example which corresponds to the above description. Three unit transistors 154 are formed for the D0 bit. One of them is a regular unit transistor 154 and the other two are unit transistors 154 (more correctly called adjustment transistors) to be adjusted, or cut off if necessary, by trimming.

In the same way, four unit transistors 154 are formed for the D1 bit. Two of them are regular unit transistors 154 and the other two are unit transistors 154 (more correctly called adjustment transistors) to be adjusted, or cut off if necessary, by trimming. Similarly, eight unit transistors 154 are formed for the D2 bit. Four of them are regular unit transistors 154 and the other four are unit transistors 154 (more correctly called adjustment transistors) to be adjusted, or cut off if necessary, by trimming.

Thus, the adjustment transistors 154 (indicated by B in FIG. 171) are trimmed or the like to adjust output current. Transistors indicated B are placed along the line indicated by arrow A. Consequently, during scanning by a laser light or the like, the adjustment transistors can be trimmed by scanning in a single direction. This allows rapid scanning.

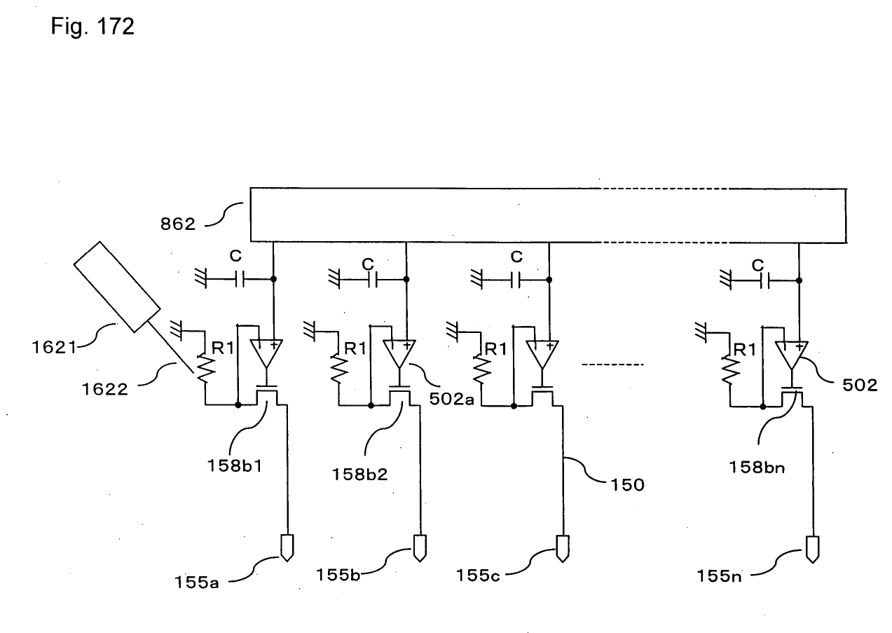

In the above example, the output stages are composed of unit transistors 154 and the like. However, regarding methods of adjusting output current by trimming, the present invention is not limited to this. For example, the methods can be applied to configurations in which the output stage connected to each output terminal is composed of an operational amplifier 502, transistor 158b, and resistor R1, as illustrated in FIG. 172.

Each of the output stages illustrated in FIG. 172 is composed of the operational amplifier 502, transistor 158b, and resistor R1. The magnitude of current is adjusted by the resistor R1 and gradations are represented by gradation voltages outputted from a circuit 862.

Each output stage in FIG. 172 is trimmed by being irradiated with a laser light 1622 or the like from a laser device 1621. By trimming the resistors R1 in the respective output stages in sequence, it is possible to eliminate variations in the output current.

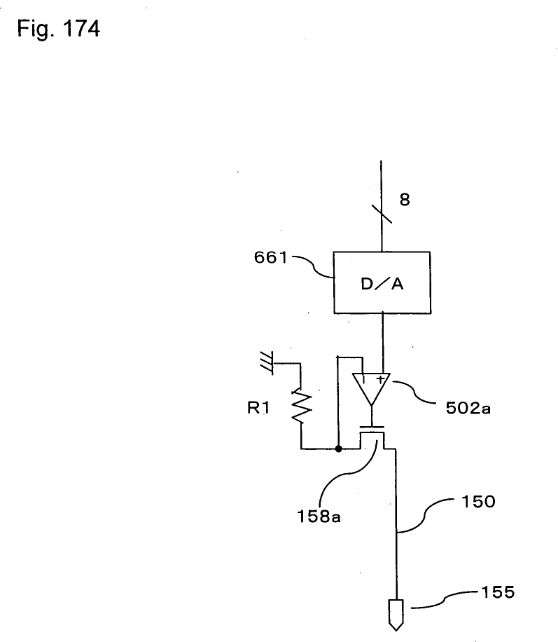

Incidentally, in FIG. 172, the output current depends on an analog voltage outputted from the circuit 862. However, the present invention is not limited to this. Needless to say, 8-bit digital data may be converted into an analog voltage by a D/A circuit 661 and applied to an operational amplifier 502a as illustrated in FIG. 174.

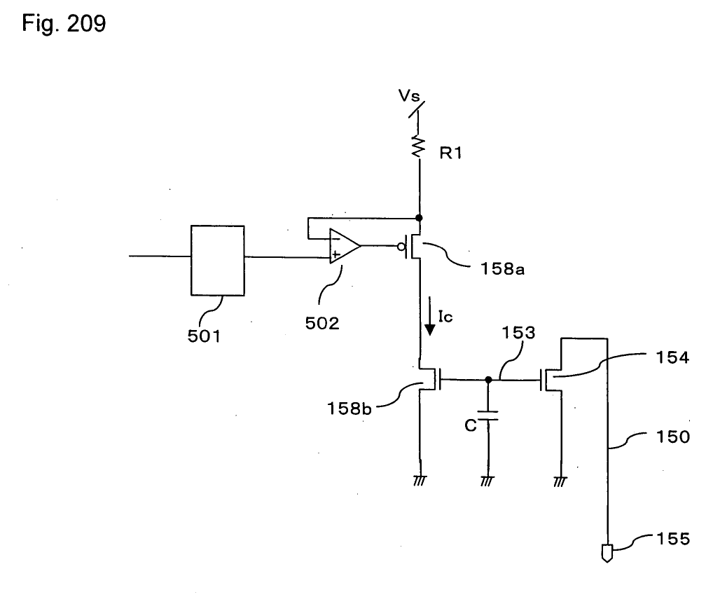

As illustrated in FIG. 209, the output stage may be provided as a current mirror circuit composed of a transistor 154 and a transistor 158b which passes a current corresponding to video data. Each output stage constitutes a current circuit composed of a D/A circuit 501, operational amplifier 502, built-in resistor R1, transistor 158a, etc. By subjecting the resistor R1 to trimming or the like, it is possible to minimize output variations.

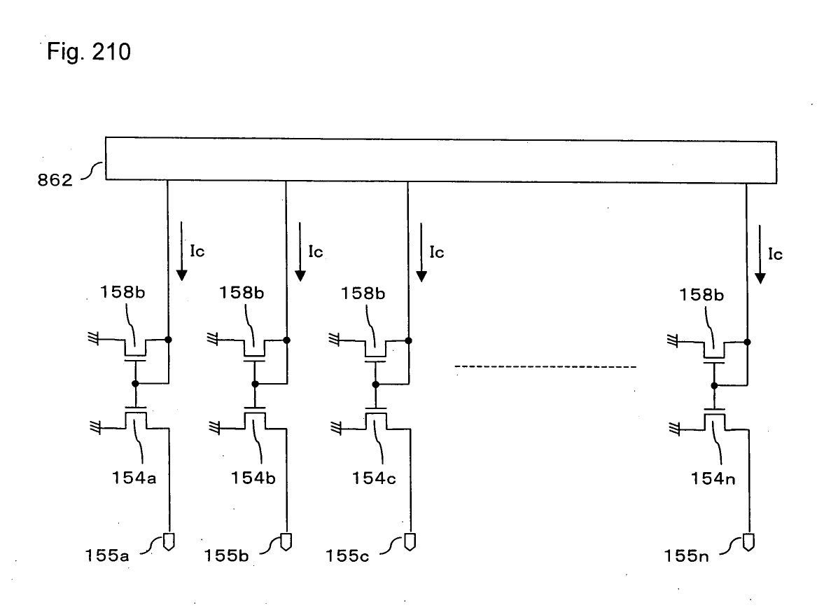

FIG. 210 shows a configuration similar to the one shown in FIG. 209. The current Ic corresponding to video data is supplied from a sampling circuit 862 to the transistor 158b. The transistor 158b and transistor 154 compose an N-fold current mirror circuit.

Although it has been stated with reference to FIG. 172 that the resistors R1 are trimmed in sequence as required, the present invention is not limited to this. Needless to say, for example, the output stages 431c may be trimmed as required. The need for trimming is determined by bringing the terminal 155 into contact with test terminals 1734 or the like and connecting it to an ammeter (current measuring means) 1733 via selector switches 1731 and a common line 1732. The selector switches 1731 are turned on in sequence to apply the current from the output stages 431c to the ammeter 1733. Trimming means 1632 trims unit transistors, resistors, etc. and thereby adjusts them to predetermined values based on the current value measured on the ammeter 1733.

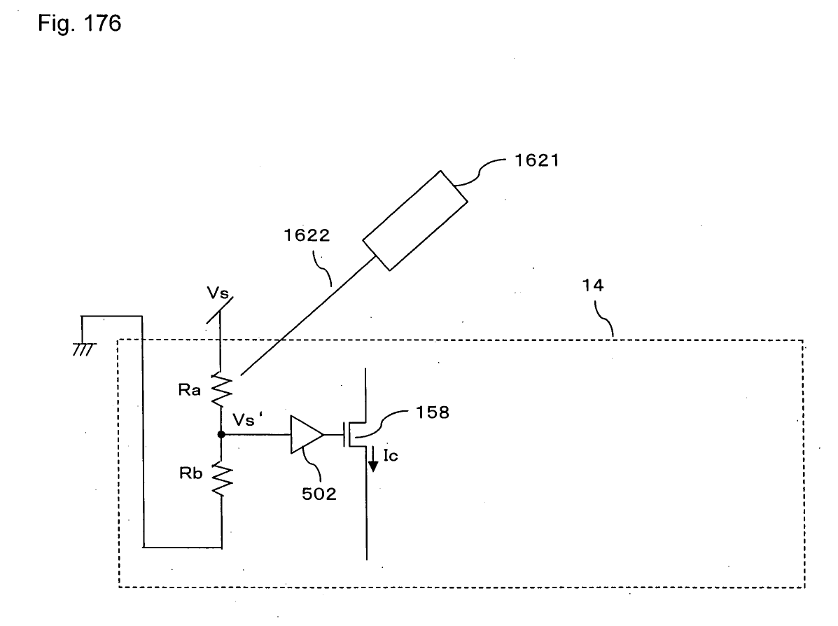

The above example involves changing or adjusting variations in output current by trimming current output stages and the like. However, the present invention is not limited to this. Needless to say, for example, the output current may be varied or adjusted by trimming resistors Ra, Rb, etc. used to produce reference current of a predetermined value and thereby adjusting the reference current Ic as illustrated in FIG. 176.

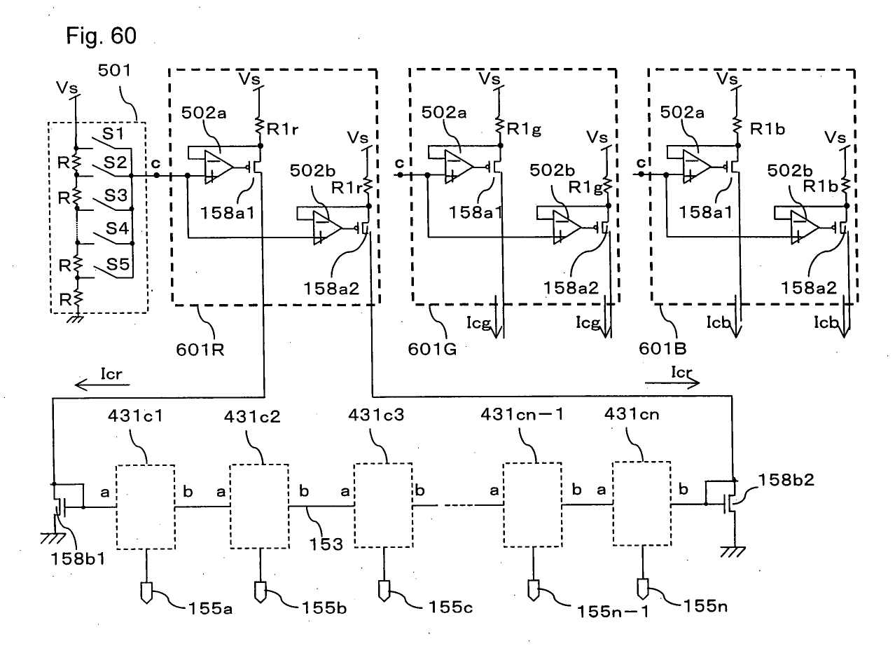

The circuit configuration in FIG. 60, etc. allows easy white balance adjustment. First, R, G, and B electronic regulators 501 are set to the same set value. Then, the white balance is adjusted by operating external resistors R1r, R1g, and R1b.

With the source driver circuit (IC) 14, once white balance is achieved by any of the electronic regulators, brightness of the display screen 144 can be adjusted, with the white balance maintained, by setting the electronic regulators 501 to the same value. Reference numeral 601 denotes reference current circuit.

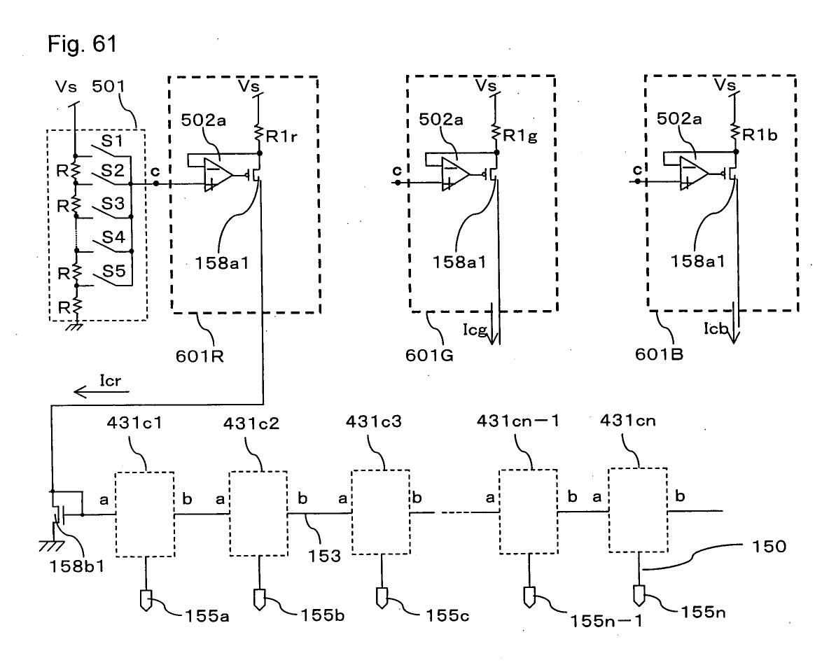

Although with the configuration in FIG. 60, current is supplied to the transistor groups 431c from both sides, the above items are not limited to this configuration. They similarly apply to a single-side current-supply configuration shown in FIG. 61. With the electronic regulators 501 set to the same set value, the white balance is adjusted by operating the external resistors R1r, R1g, and R1b. Generally, white balance is achieved as Icr of an R circuit, Icg of a G circuit, and Icb of a B circuit are set to predetermined ratios by taking into consideration the luminous efficiency of the EL elements.

With the source driver circuit (IC) 14, once white balance is achieved by any of the electronic regulators, brightness of the display screen 144 can be adjusted, with the white balance maintained, by setting the electronic regulators 501 to the same value. Incidentally, it is preferable to form or arrange separate electronic regulators for R, G, and B, but this is not restrictive. For example, even a single electronic regulator 501 common to R, G, and B allows the brightness of the display screen 144 to be adjusted with white balance maintained.

By forming or placing electronic regulators in the source driver circuit (IC) 14, the present invention allows reference current to be varied or changed by digital data control from outside the source driver circuit (IC) 14. This is important for current drivers. In current driving, video data is proportional to the current flowing through the EL elements 15. Thus, by performing logical processing on the video data, it is possible to control the current flowing through all the EL elements. Since the reference current is also proportional to the current flowing through the EL elements 15, by digitally controlling the reference current, it is possible to control the current flowing through all the EL elements 15. Thus, by performing logical reference current control based on the video data, the dynamic range of display brightness can be extended easily.

The output current of the unit transistors 154 can be varied by changing or varying the reference current. For example, assume that when the reference current Ic is 100 μA, the output current of one unit transistor 154 is 1 μA in the ON state. In this state, if the reference current Ic is set to 50 μA, the output current of the unit transistor 154 becomes 0.5 μA. Similarly, if the reference current Ic is set to 200 μA, the output current of the unit transistor 154 becomes 2.0 μA. In short, it is preferable that the output current Id of the unit transistor 154 is proportional to the reference current Ic (see solid line a in FIG. 62).

Preferably, the reference current Ic is proportional to setting data which specifies the reference current Ic. For example, if the reference current Ic is 100 μA when the setting data indicates 1, the reference current Ic should be 200 μA when the setting data indicates 100. In short, it is preferable that as the setting data increases by 1, the reference current Ic increases by 1 μA.

By using the setting-data of electronic regulators 501, this configuration allows R, G, and B reference currents (Icr, Icg, and Icb) to vary while maintaining a linear relationship. Since the linear relationship is maintained, once white balance is adjusted using the setting data for any of the reference currents, the white balance is maintained for any setting data. The adjustment of white balance by means of the external resistors R1r, R1g, and R1b (described above) is an important feature of this configuration.

Although the external resistors are used for white balance adjustment in the above example, it goes without saying that the resistors R1 may be incorporated in the IC chip.

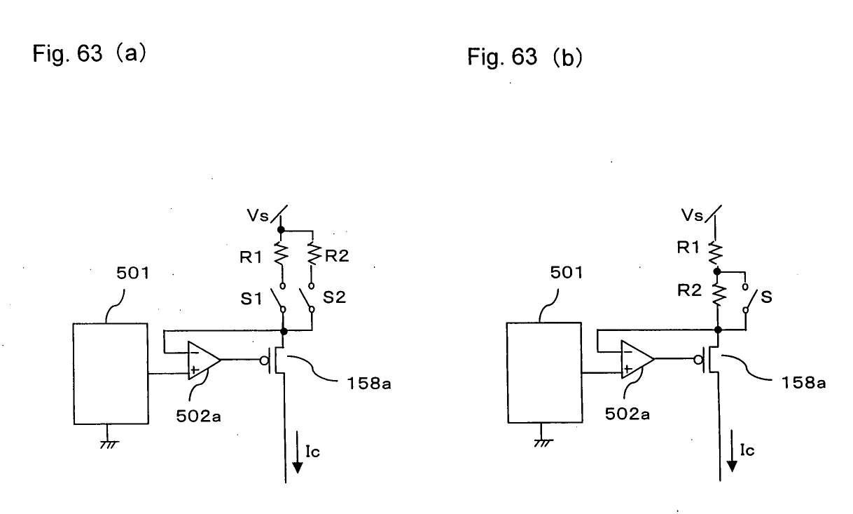

Also, as illustrated in FIG. 63, switches S may be added to adjust or control resistance. In FIG. 63(a), for example, when switch S1 is selected, the external resistor is R1, and when switch S2 is selected, the external resistor is R2. When both switches S1 and S2 are selected, the external resistors R1 and R2 are connected in parallel, producing corresponding resistance.

FIG. 63(b) shows a configuration in which the resistors R1 and R2 are connected in series so that they can be added (R1+R2) or only the external resistor R1 can be enabled under the control of the switch S.

The configuration in FIG. 63 allows the variable range of the reference current Ic to be extended because the configuration makes it possible not only to adjust the setting data of the electronic regulator 501, but also to adjust the reference current under the control of the switches S. This makes it possible to extend the brightness adjustment range (dynamic range) of the EL display panel.

According to the present invention, one step of the electronic regulator 501 causes an approximately 3% change in the reference current. For example, if the reference current increases 3-fold from its basic magnitude and the electronic regulator has 64 steps or 6 bits, then (3−1)/64=0.03, i.e., approximately 3%.

If the reference current changes greatly per step, the brightness of the display screen 144 will change greatly when the electronic regulator is operated. This will result in perception of flickering. Conversely, if the change in the reference current per step is small, the change in the brightness of the display screen 144 is also small, resulting in a narrow dynamic range of brightness adjustment. On the other hand, increasing the number of steps will lead directly to an increase in the size of the electronic regulator 501, thereby increasing the size of the source driver IC 14 and resulting in increased costs.

Thus, it is preferable that a change in the reference current per step is between 1% and 8% (both inclusive) of the basic current (on the basis of a base). Between 1% and 5% (both inclusive) is more preferable. For example, if the electronic regulator 501 is 8 bits (256 steps) and the reference current increases 10-fold from its basic magnitude, then (10−1)/256=3.5%. This satisfies the condition of between 1% and 5% (both inclusive).

The change in the reference current per step has been described in the above example. However, since changes in the reference current correspond to changes in screen brightness, it goes without saying that the change in the reference current per step translates into a change in the brightness of the display screen 144 or change in anode (or cathode) current per step.

Although it has been stated in the above example that the output current Id of the unit transistor 154 is preferably proportional to the reference current Ic as indicated by solid line a in FIG. 62, this is not restrictive. For example, as indicated by dotted line b in FIG. 62, a non-linear relationship (preferably in a range of between the 1.8-th power to the 2.8-th power) can be used. The use of a non-linear relationship (preferably in a range of between the 1.8-th power to the 2.8-th power) brings changes in the reference current with respect to design data of the electronic regulator 501 close to a square curve of human vision. This results in good gradation characteristics.

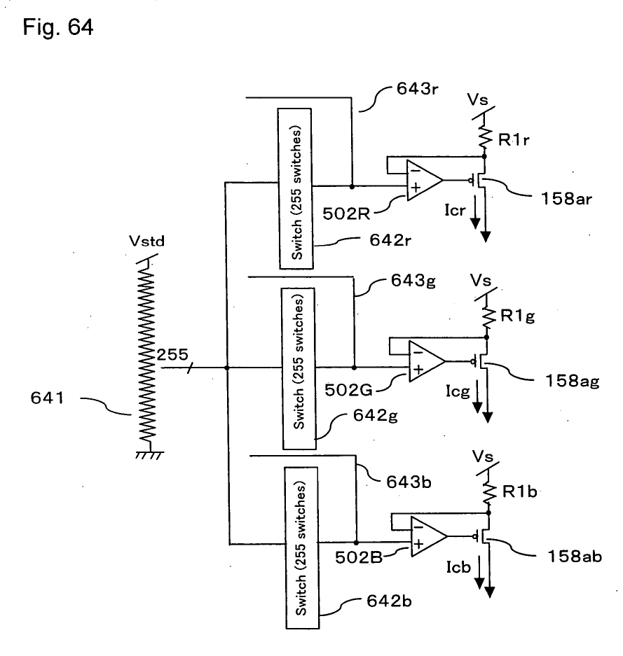

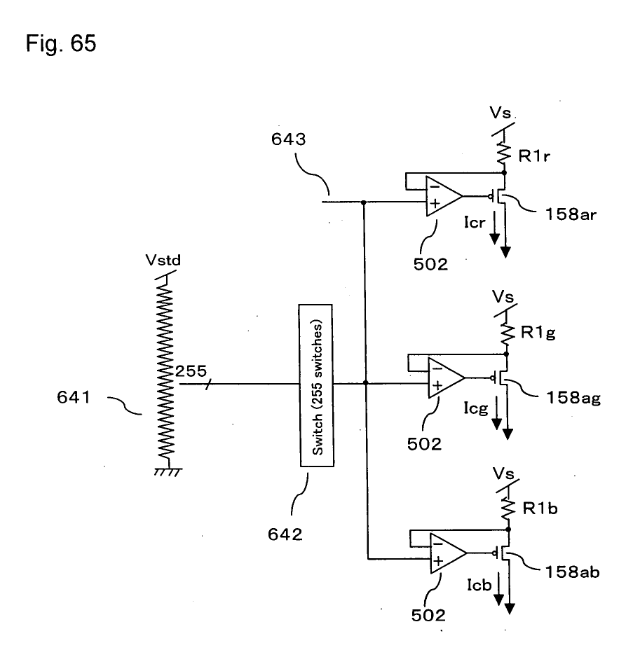

Although it has been stated in the above example that the reference current is varied using setting data of the electronic regulator 501, this is not restrictive. Needless to say, the reference current may be varied, adjusted or controlled using voltage input/output terminals 643 as illustrated in FIGS. 64 and 65.

The electronic regulator 501 in FIGS. 50, 60 and 61 may be configured as shown in FIG. 64, in which the ladder resistor 641 (resistor array or transistor array) and switches 642 correspond to the electronic regulator 501. The ladder resistor 641 may be of any type as long as it regulates a voltage at regular intervals or in predetermined increments/decrements. For example, it may be composed of diode-connected transistors or provided by on-resistance of transistors.

Preferably, the electronic regulator 501 used to produce the reference current Ic or means of producing the reference current Ic is configured as shown in FIG. 500. FIG. 500 illustrates the configuration shown in FIG. 65. It is not limited to the configuration in FIG. 65 and is also applicable to other configurations according to the present invention. Needless to say, the items described below also apply to precharge voltage Vpc generation circuits, too.

As illustrated in FIG. 500, in the electronic regulator 501, resistors R incorporated in the source driver circuit (IC) 14 are formed or placed in series. Also, a built-in resistor Ra is connected between a switch S1 and reference voltage Vstd. A built-in resistor Rb is connected between a switch Sn and ground voltage GND. The reference voltage Vstd is a precise fixed voltage. Thus, even if the Vdd voltage of the EL display panel fluctuates, the Vstd voltage does not fluctuate. This is intended to keep the brightness of the display panel constant by preventing fluctuations in the reference current Ic, which would be caused by any change in Vstd.

Since the resistors Ra, R, and Rb are polysilicon resistors incorporated in the source driver circuit (IC) 14 as described above, relative values of the resistors Ra, R, and Rb do not fluctuate even if the sheet resistance of individual polysilicon resistors in the source driver circuit (IC) 14 fluctuates. Thus, the source driver. circuit (IC) 14 is free of variations in the reference current Ic.

The R reference current Icr depends on the output current of the electronic regulator 501 and the resistor R1r. The G reference current Icg depends on the output current of the electronic regulator 501 and the resistor R1g. The B reference current Icb depends on the output current of the electronic regulator 501 and the resistor R1b. The reference voltage Vstd is shared among R, G, and B and white balance is adjusted by the resistors R1r, R1g, and R1b. For the electronic regulator 501, the built-in resistors Ra, R, and Rb are brought to the same relative value and the voltage is set to Vstd. This makes it possible to keep the reference currents Icr, Icg, and Icb constant among the source driver circuits (IC) 14 with high accuracy. IDATA used to vary the reference current Ic is controlled by a control circuit (IC) 760.

The resistors R1r, R1g, and R1b are external resistors or external variable resistors. If the reference voltage Vstd is not used or if a voltage corresponding to the reference voltage Vstd is desired to be varied or adjusted, preferably a switch SW1 is designed to allow an external voltage Vs to be applied. Furthermore, it is preferable that a switch SW2 is designed to allow an external voltage Va to be applied to vary or change the potential of the switch S1. Also, although not shown in FIG. 500, a voltage application terminal is provided outside the source driver circuits (IC) 14 to allow the output voltage of the switch Sn to be changed.

Now, mainly with reference to FIG. 501, description will be given of an EL display apparatus (EL display panel) which uses a source driver circuit (IC) 14 as well as of the source driver circuit (IC) 14 comprising a transistor 158ar which prescribes a reference current Icr to be applied to red pixels, a transistor 158ag which prescribes a reference current Icg to be applied to green pixels, a transistor 158ab which prescribes a reference current Icb to be applied to blue pixels, and control means 501 (501a and 501b) for controlling the transistor 158ar, the transistor 158ag, and the transistor 158ab, wherein the control means 501 (501a and 501b) varies the magnitudes of the reference current Icr, reference current Icg, and reference current Icb proportionally.

Preferably, the reference voltage Vstd can also be changed or varied by data applied to a DA conversion circuit 501b as illustrated in FIG. 501. Also, as illustrated in FIG. 502, a current Ir generated by a constant-current circuit consisting of a transistor 158 and operational amplifier may be passed through a built-in resistor R of the electronic regulator 501 to allow a voltage outputted from terminal b to be varied.

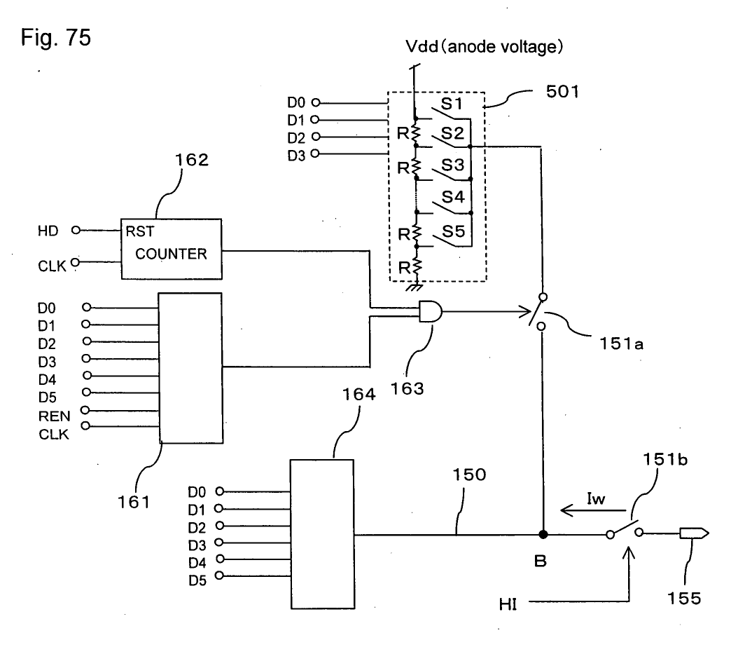

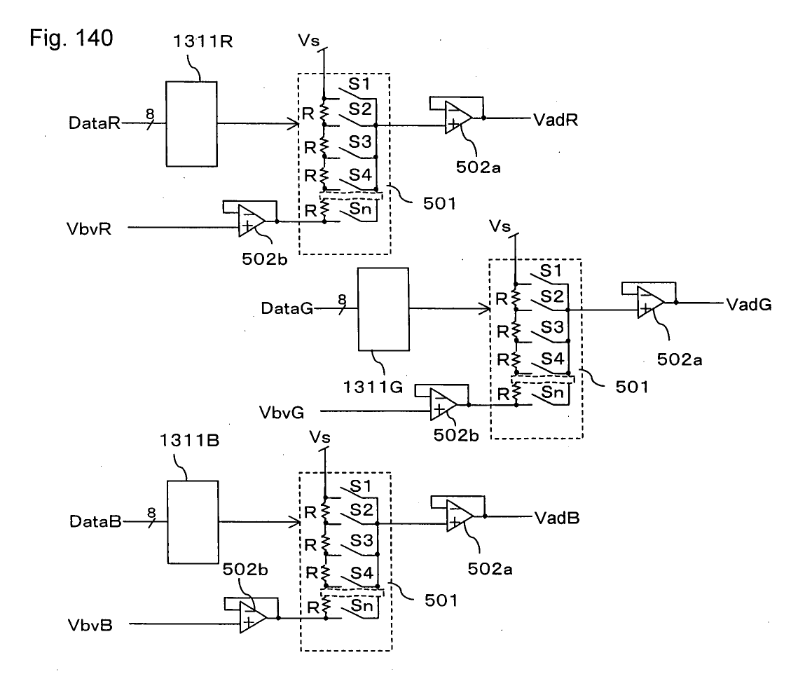

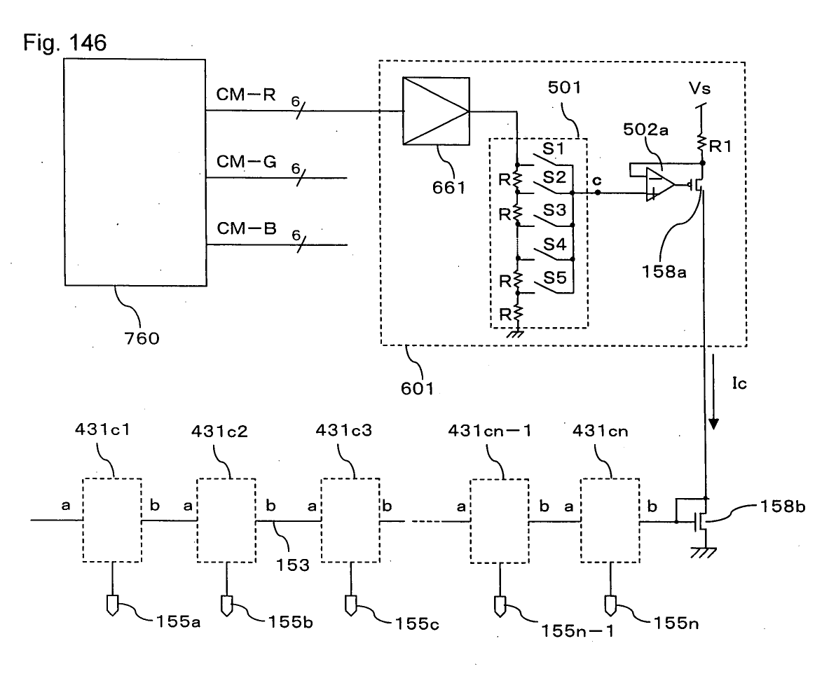

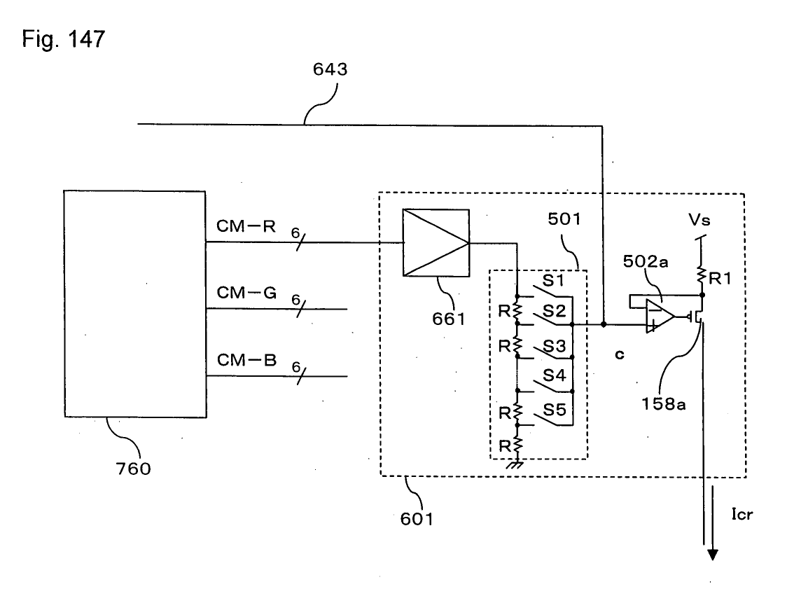

Needless to say, the configuration or system consisting of the ladder resistor 641 and switch circuits 642 as well as the configuration or system of the voltage input/output terminals 643 are also applicable to the precharging configuration in FIG. 75, the color management and processing configuration in FIGS. 146 and 147, the voltage programming configuration in FIGS. 140, 141, 143, 607, etc.

Further, configurations shown in FIGS. 64 and 65 are applicable to those in FIGS. 56 and 57. They are also applicable to configurations, such as the one shown in FIG. 50, in which reference current is applied to the source driver circuit (IC) 14 from both sides. Moreover, it goes without saying that they are applicable to configurations shown in FIGS. 46 and 61.

In FIG. 64, the transistor 158ar generates the reference current Icr for the R circuit, the transistor 15ag generates the reference current Icg for the G circuit, and the transistor 158ab generates the reference current Icb for the B circuit.

In FIG. 64, the ladder resistor 641 is shared among three switch circuits (642r, 642g, and 642b) for R, G, and B. This reduces the formation area of the ladder resistor 641 in the source driver circuit (IC) 14.

In FIGS. 64 and 65 again, the setting data of the switch circuits 642 allows the R, G, and B reference currents (Icr, Icg, and Icb) to be varied with a linear relationship maintained. Since the linear relationship is maintained, once white balance is adjusted using the setting data for any of the reference currents, the white balance is maintained for any setting data. This configuration makes it possible to achieve white balance by adjusting the external resistors R1r, R1g, and R1b.

In FIG. 64, the voltage input/output terminals 643 are used to enter analog voltage from out of the source driver circuit (IC) 14. The analog voltage allows the reference currents Ic to be varied or adjusted. This makes it possible to adjust white balance as well as the brightness of the display screen 144 without using the switch circuits 642.

FIG. 346 shows a variation of FIG. 65. In FIG. 346, the electronic regulator 501 is shared among reference current generator circuits for red, green, and blue colors. The magnitudes of the R, G, and B reference currents are adjusted by internal or external resistors R (R1 for red, R2 for green, and R3 for blue) or built-in resistors of the source driver circuit (IC) 14 to maintain white balance. If the resistors R are of a built-in type, they are adjusted by trimming or the like so that white balance can be achieved. Of course, the external resistors R may be regulators.

Also, the resistors R may be of any type as long as they provide means of adjusting or setting reference currents. They may be non-linear elements such as Zener diodes, transistors, or thyristors. Also, they may be such circuits or elements as constant-voltage regulators or switching power supplies. Posistors, thermistors, or other elements may be used instead of the resistors R. These elements will allow temperature compensation in addition to adjustment or setting of reference currents. Besides, constant-current circuits which generate reference currents may be used.

In FIG. 346, a switch in the electronic regulator 501 is specified by IDATA (reference current setting data) and a Vx voltage (reference current setting voltage) is outputted from the electronic regulator 501. The Vx voltage is applied to the positive terminals of the operational amplifiers 502 (502R for red, 502R for green, and 502R for blue). Thus, the reference current for red is given by Icr=2 Vx/R1, the reference current for green is given by Icr=2 Vx/R2, and the reference current for blue is given by Icr=2 Vx/R3. These reference currents are used to achieve white balance. Also, these reference currents determine the magnitudes of the R, G, and B programming currents (see FIGS. 60, 61, etc.) Incidentally, the reference currents can be set at relatively long intervals such as every frame (every field) because it is sufficient to set them in accordance with a changing screen (images).

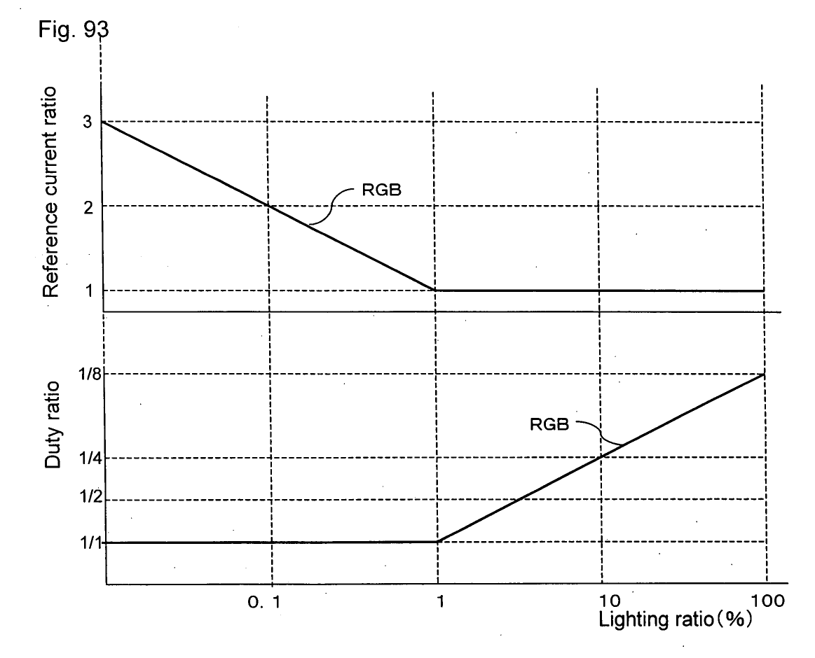

The magnitudes of the R, G, and B reference currents vary with IDATA, and the size of IDATA and the R, G, and B reference currents vary, maintaining a linear relationship. Thus, white balance is maintained even if IDATA varies. Also, the brightness of the display screen 144 varies in proportion to the size of IDATA (provided the duty ratio is kept constant). That is, IDATA allows the brightness of the display screen 144 to be controlled linearly with white balance maintained. The linear variation makes it very easy to use this control method in combination with duty ratio control (see FIGS. 93 to 116, etc.). This is a useful feature of the present invention. Other points are the same as in FIGS. 64, 65, etc. and thus description thereof will be omitted.

With the configuration in FIG. 346, as the electronic regulator 501 is operated, the ratio among the R, G, and B reference currents varies simultaneously (their ratio remains constant). The configuration in FIG. 526 allows the magnitude of the R reference current IcR, the G reference current IcG, and the B reference current IcB to be varied individually.

The R reference current IcR can be varied by varying the number of closed switches out of the switches Sr1 to S3R. A 2-bit external terminal Sa (not shown) of the source driver circuit (IC) 14 is used to select which of the switches Sr1 to Sr3 should be closed/opened. If data inputted in the terminal Sa for R indicates 0, all the switches Sr1 to Sr3 are open. Thus, the reference current IcR is 0 and no programming current Iw is outputted from the terminal 431cR. No overcurrent Id is outputted either. If the data inputted in the terminal Sa for R indicates 1, one switch Sr1 is closed and the switches Sr1 and Sr2 are open. Consequently, a one-fold reference current IcR flows and a one-fold programming current Iw is outputted from the terminal 431cR. Besides, one-fold overcurrent Id is outputted depending on control status of the source driver circuit (IC) 14.

Similarly, if data inputted in the terminal Sa for R indicates 2, the switches Sr1 and Sr2 are close and the switch Sr3 is open. Thus, a two-fold reference current IcR flows and two-fold programming current Iw is outputted from the terminal 431cR. Besides, two-fold overcurrent Id is outputted depending on control status of the source driver circuit (IC) 14. If data inputted in the terminal Sa for R indicates 3, all the switches Sr1 to Sr3 are close. Thus, a three-fold reference current IcR flows and three-fold programming current Iw is outputted from the terminal 431cR. Besides, three-fold overcurrent Id is outputted depending on control status of the source driver circuit (IC) 14.

Similarly, the G reference current IcG can be varied by varying the number of closed switches out of the switches Sg1 to Sg3. A 2-bit external terminal Sa (not shown) corresponding to G of the source driver circuit (IC) 14 is used to select which of the switches Sr1 to Sr3 should be closed/opened. If data inputted in the terminal Sa for G indicates 0, all the switches Sg1 to Sg3 are open. Thus, the reference current IcG is 0 and no programming current Iw is outputted from the terminal 431cG. No overcurrent Id is outputted either. If the data inputted in the terminal Sa corresponding to G indicates 1, one switch Sg1 is closed and the switches Sg1 and Sg2 are open. Thus, a one-fold reference current IcG flows and one-fold programming current Iw is outputted from the terminal 431cG. Besides, one-fold overcurrent Id is outputted depending on control status of the source driver circuit (IC) 14.

If data inputted in the terminal Sa corresponding to G indicates 2, the switches Sg1 and Sg2 are close and the switch Sg3 is open. Thus, a two-fold reference current IcG flows and two-fold programming current Iw is outputted from the terminal 431cG. Besides, two-fold overcurrent Id is outputted depending on control status of the source driver circuit (IC) 14. If data inputted in the terminal Sa corresponding to G indicates 3, all the switches Sg1 to Sg3 are close. Thus, a three-fold reference current IcG flows and three-fold programming current Iw is outputted from the terminal 431cG. Besides, three-fold overcurrent Id is outputted depending on control status of the source driver circuit (IC) 14.

B is also similar, and the B reference current IcB can be varied by varying the number of closed switches out of the switches Sb1 to Sb3. A 2-bit external terminal Sa (not shown) corresponding to B of the source driver circuit (IC) 14 is used to select which of the switches Sg1 to Sg3 should be closed/opened. If data inputted in the terminal Sa corresponding to B indicates 0, all the switches Sb1 to Sb3 are open. The reference current IcB is 0 and no programming current Iw is outputted from the terminal 431cB. No overcurrent Id is outputted either.

If the data inputted in the terminal Sa corresponding to B indicates 1, one switch Sb1 is closed and the switches Sb1 and Sb2 are open. Consequently, a one-fold reference current IcB flows and a one-fold programming current Iw is outputted from the terminal 431cB. Besides, one-fold overcurrent Id is outputted depending on control status of the source driver circuit (IC) 14.

If data inputted in the terminal Sa corresponding to B indicates 2, the switches Sb1 and Sb2 are close and the switch Sb3 is open. Thus, a two-fold reference current IcB flows and two-fold programming current Iw is outputted from the terminal 431cB. Besides, two-fold overcurrent Id is outputted depending on control status of the source driver circuit (IC) 14. If data inputted in the terminal Sa corresponding to B indicates 3, all the switches Sb1 to Sb3 are close. Thus, a three-fold reference current IcG flows and three-fold programming current Iw is outputted from the terminal 431cB. Besides, three-fold overcurrent Id is outputted depending on control status of the source driver circuit (IC) 14.

In FIGS. 64, 65, etc., the switch circuit 642 is configured such that all the switches are opened when the setting data indicates 0. Thus, when the setting data of the switch circuit 642 indicates 0, the input voltage of the voltage input/output terminal 642 is enabled. When the setting data of the switch circuit 642 indicates other than 0, the voltage from the ladder resistor 641 is inputted in the positive terminal of the operational amplifier 502.

The voltage input/output terminal 643 also functions as a monitor terminal for the output voltage of the switch circuit 642. That is, when selection voltages from the ladder resistor 641 are selected by the switch circuit 642, the voltage input/output terminal 643 can monitor which of the selected voltages is inputted in the operational amplifier 502.

In FIG. 64, a large chip area is required because there are a large number of wires between the ladder resistor 641 (incremental voltage output means) and the switch circuits 642. FIG. 65 shows an example in which a single switch circuit 642 is used for R, G, and B. This configuration also makes it possible to carry out white balance adjustment, etc. without practical problems.

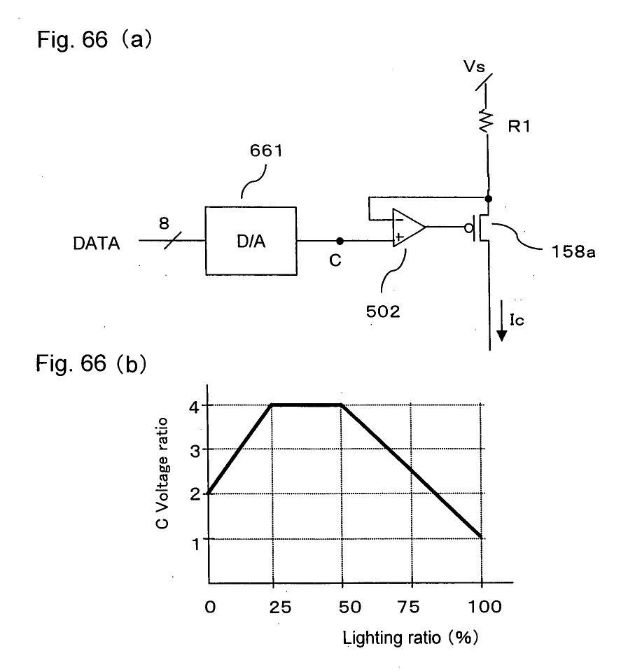

The above example involves varying the settings of the electronic regulator 501 and switch circuit 642 using digital setting data. However, the present invention is not limited to this. Needless to say, for example, the reference currents Ic may be controlled by varying (changing) the input voltage (indicated by point c) of the operational amplifier 502 using a digital-to-analog conversion circuit (D/A circuit) 661 as illustrated in FIGS. 66(a) and 66(b).

FIG. 371 shows another example of a configuration or system for use to adjust or control reference current. The R, G, and B reference currents are determined by resistors R1 (R1r, R1g, and R1b), which are also used to adjust white balance. Reference character R1 (R1r, R1g, R1b) denotes an external resistor.

A resistor Rs is also an external resistor. By varying the resistor Rs, the brightness in the source driver IC 14 can be adjusted with white balance maintained. Thus, a plurality of source driver ICs 14 can be cascaded easily by adjusting the resistor Rs. The resistor Rs may be a regulator. The resistance may be adjusted by trimming. Alternatively, it may be adjusted or varied using an electronic regulator.

FIG. 378 shows a configuration in which the terminal voltages of the resistors R1 are changed by electronic regulators 501b. The electronic regulators 501b are adjusted by DATA. The output voltage of the electronic regulator 501bR is applied to one terminal of the resistor R1r. The output voltage of the electronic regulator 501bR can be varied by 8-bit RData. Thus, reference current Ir is varied by RData.

Similarly, the output voltage of the electronic regulator 501bG is applied to one terminal of the resistor Rlg. The output voltage of the electronic regulator 501bG can be varied by 8-bit GData. Thus, reference current Ir is varied by GData. Also in the same way, the output voltage of the electronic regulator 501bB is applied to one terminal of the resistor R1b. The output voltage of the electronic regulator 501bB can be varied by 8-bit BData. Thus, reference current Ir is varied by BData.

The above configuration makes it possible to adjust white balance and reference currents by controlling the electronic regulators 501b.

FIG. 379 shows a variation of FIG. 377. An electronic regulator is used as the resistor Rs. The electronic regulator 501 is incorporated in the source driver circuit (IC) 14. The output current of the electronic regulator 501 can be varied or controlled by SATA. The terminal voltages of the resistors R1 (R1r, R1g, and R1b) can be controlled by SATA. The R, G, and B reference currents are determined by the resistors R1 (R1r, R1g, and R1b). The resistors R1 (R1r, R1g, and R1b) are used to adjust white balance. The resistors R1 (R1r, R1g, and R1b) are installed externally. Other items are the same or similar as/to in FIG. 377 and thus description thereof will be omitted.

Needless to say, the above examples can be combined with each other or with other examples of the present invention.

With a source driver circuit (IC) 14 as shown in FIG. 44, in particular, when images are displayed on a display panel, current applied to source signal lines 18 causes fluctuations in potential of source signal line 18, which in turn cause the gate wiring 153 of the source driver IC 14 to swing (See FIG. 52). As illustrated in FIG. 52, linking occurs on the gate wiring 153 at points where the video signal applied to the source signal line 18 varies. Since the potential of the gate wiring 153 is varied by the linking, the gate potential of the unit transistor 154 varies, resulting in fluctuations of the output current. Potential fluctuations in the gate wiring 153, in particular, cause cross-talk (horizontal cross-talk) along gate signal lines 14.

The fluctuations (the linking of the gate wiring 153 (see FIG. 52)) is related to the power supply voltage of the source driver IC 14. That is, the higher that power supply voltage, larger the wave height of linking. In the worst case, the power supply voltage also oscillates. The steady-state value of the voltage of the gate wiring 153 is 0.55 to 0.65 V. Thus, even slight linking causes the output current to fluctuate greatly.

FIG. 67 shows a ratio of potential fluctuations of the gate wiring based on the value obtained when the power supply voltage of the source driver IC 14 is 1.8 V. The fluctuation ratio increases with increases in the power supply voltage of the source driver IC 14. An allowable range of fluctuation ratio is approximately 3. A higher fluctuation ratio will cause horizontal cross-talk. The fluctuation ratio with respect to the power supply voltage tends to increase when the power supply voltage of the IC is 13 to 15 V or higher. Thus, the power supply voltage of the source driver IC 14 should be 13 V or less.

On the other hand, in order for a driver transistor 11a switch from white-display current to black-display current, it is necessary to make a certain amplitude change to the potential of the source signal line 18. The required range of amplitude change is 2.5 V or more. It is lower than the power supply voltage because the output voltage of the source signal line 18 cannot exceed the power supply voltage.

Thus, the power supply voltage of the source driver IC 14 should be from 2.5 V to 13 V (both inclusive). More preferably, the power supply voltage (working voltage) of the source driver IC 14 is between 6 and 10 V (both inclusive). The use of this range makes it possible to keep fluctuations in the gate wiring 153 within a stipulated range, eliminate horizontal cross-talk, and thus achieve proper image display.

Wiring resistance of the gate wiring 153 also presents a problem. In FIG. 47, the wiring resistance (Ω) of the gate wiring 153 is the value of the resistance of the wiring throughout its length from transistor 158b1 to transistor 158b2 or the resistance of the gate wiring throughout its length. Also, in FIG. 46, it is the value of the resistance of the wiring throughout its length from transistor 158b (transistor group 431b) to transistor group 431cn.

The magnitude of a transient phenomenon of the gate wiring 153 depends on one horizontal scanning period (1 H) as well because the shorter the period of 1 H, the larger the impact of the transient phenomenon. A larger wiring resistance (Ω) makes a transient phenomenon easier to occur. This phenomenon poses a problem especially for the source driver circuit (IC) 14 having the configurations of single-stage current-mirror connections shown in FIGS. 44 to 47, in which the gate wiring 153 is long and connected with a large number of unit transistors 154.

FIG. 68 is a graph in which the horizontal axis represents the product (R·T) of wiring resistance (Ω) of the gate wiring 153 and one horizontal scanning period (1-H period) T (sec) while the vertical axis represents a fluctuation ratio. The fluctuation ratio is taken as when R·T=100. As can be seen from FIG. 68, fluctuation ratio tends to grow larger when R·T is 5 or less. Fluctuation ratio also tends to grow larger when R·T is 1000 or more. Thus, it is preferable that R·T is from 5 to 1000 (both inclusive). Further, it is more preferable that R·T meets the condition that it is from 10 to 500 (both inclusive).

The duty ratio also presents a problem because it is related to increases in fluctuations of the source signal line 18. The duty ratio will be described later. The duty ratio is defined here as a ratio of intermittent driving. Let Sc (square μm) denote the total area of the unit transistors 154 in each transistor group 431c (where the total area is the W and L sizes of the unit transistors 154 in each transistor group 431c multiplied by the number of the unit transistors 154).

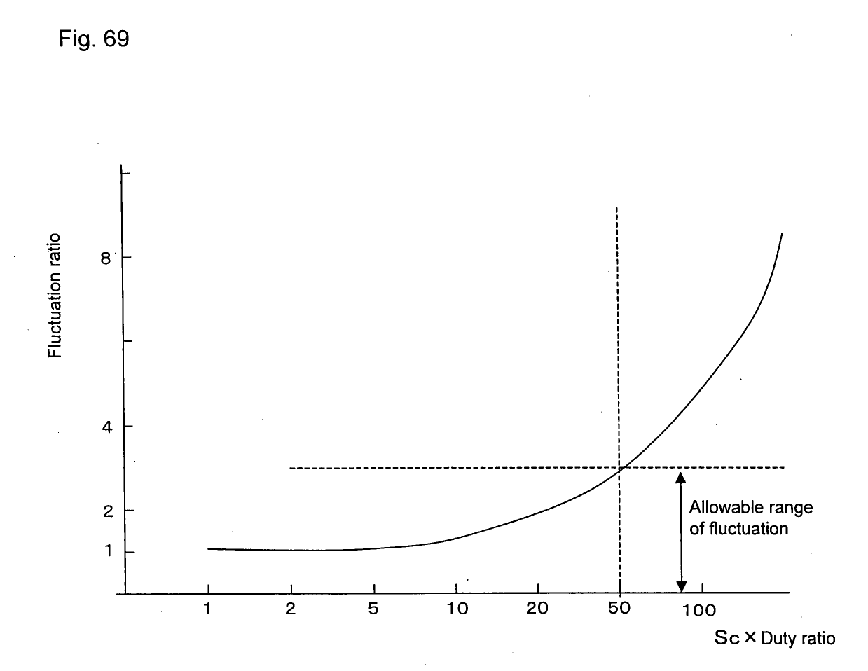

In FIG. 69, the horizontal axis represents Sc×duty ratio while the vertical axis represents a fluctuation ratio. As can be seen from FIG. 69, the fluctuation ratio tends to increase when Sc×duty ratio is 500 or more. An allowable range of fluctuation ratio is 3 or less. Thus, it is preferable that Sc×duty ratio is 500 or less.

An allowable range of fluctuations corresponds to a value of Sc×duty ratio of 500 or less. When Sc×duty ratio is 500 or less, the fluctuation ratio falls within the allowable range and potential fluctuations of the gate wiring 153 is extremely small. This makes it possible to eliminate horizontal cross-talk, keep output variations within an allowable range, and thus achieve proper image display. It is true that the fluctuation ratio falls within the allowable range when Sc×duty ratio is 500 or less. However, decreasing Sc×duty ratio to 50 or less has almost no effect. On the contrary, the chip area of the IC 14 increases. Thus, preferably Sc×duty ratio should be from 50 to 500 (both inclusive).

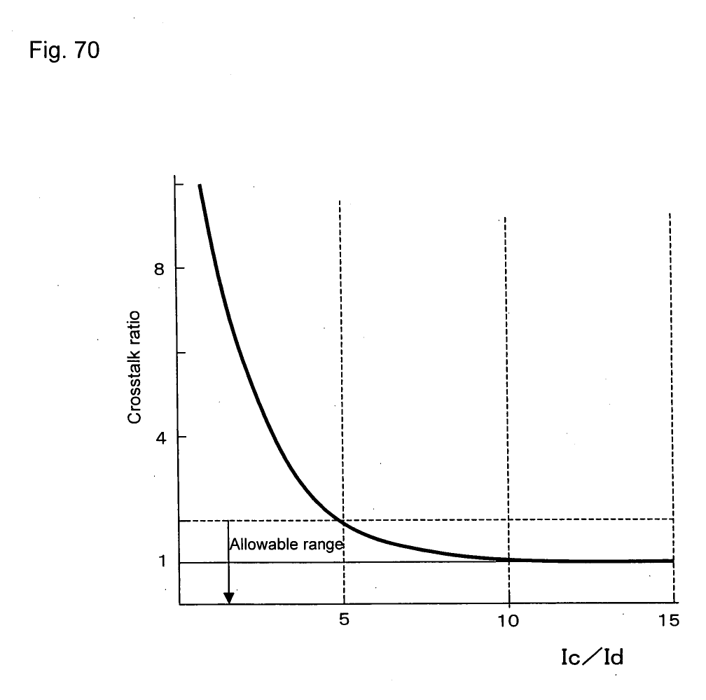

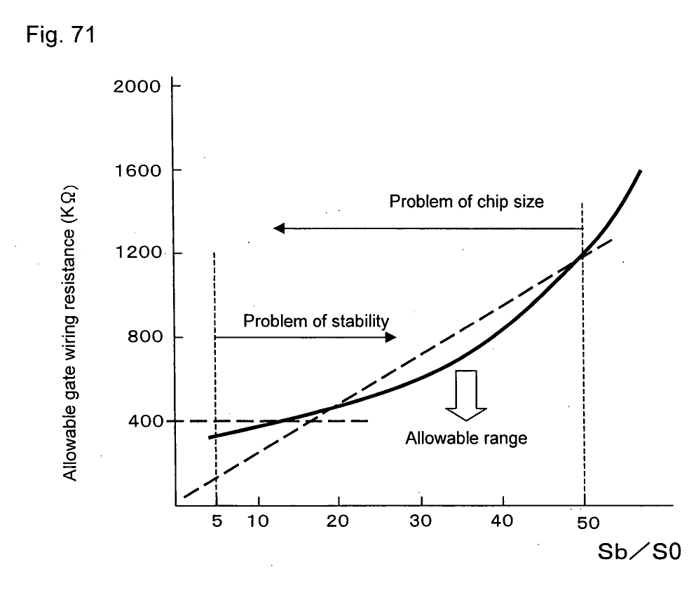

In the source driver circuit (IC) 14 according to the present invention, the transistors 158b composing current mirror circuits in conjunction with the unit transistor group 431c or the transistor group 431b composed of the transistors 158b (see FIGS. 48 and 49) preferably satisfy the relationship show in FIG. 70.

Let Ic denote the current supplied to the transistors 158b or the transistor group 431b composed of the transistors 158b (see FIGS. 48 and 49) and let Id denote the current outputted from each transistor group 431c. The current Id, which is a programming current (sink current or discharge current) outputted to the source signal line 18, flows when all the unit transistors 154 in the transistor group 431c are selected. Thus, the current Id is applied to the pixels 16 for the highest gradation.

Incidentally, if there is one 158b as shown in FIG. 46, Ic can be used as it is. If there are a plurality of transistors 158 (or a plurality of transistor groups), the sum of currents is used as Ic. Specifically, in FIG. 47, Ic=Ic1+Ic2. In this way, the current Ic is the sum total of the currents Ic flowing through the transistor group 431b which composes current mirror circuits in conjunction with the transistor groups 431c.

The ratio between the currents Id and Ic (Ic/Id) should be 5 or larger. In FIG. 70, the vertical axis represents a cross-talk ratio. Cross-talk is a phenomenon in which changes in the potential of the source signal lines 18 propagate through the gate wiring 153 of the source driver circuit (IC) 14, resulting in horizontal noise on the display screen 144. Cross-talk tends to occur where images change from white display to black display or from black display to white display (e.g., upper and lower edges of white window display). When Ic/Id is below 5, cross-talk intensifies (the cross-talk ratio increases) sharply, but when Ic/Id is above 5, the slope of the curve decreases.

Ic/Id should be 5 or larger as can be seen from 70. However Ic/Id of 100 or larger is not practical because it increases the size-of the transistor group 431b composed of the transistors 158b. Thus, Ic/Id should be between 5 and 100 (both inclusive). More preferably, it is between 8 and 50 (both inclusive).

The horizontal scanning time should also be taken into consideration in determining Ic/Id because the time constant of the gate wiring 153 needs to be decreased as the horizontal scanning period H becomes shorter. Incidentally, one horizontal scanning period can be considered to be a period required to write programming current (programming voltage) into a pixel row. That is, one horizontal scanning period is a period during which pixels are selected and current (voltage) is written into the pixels 16. This period corresponds to two horizontal scanning periods in the case of a drive method in which two pixel rows are selected simultaneously.

If one horizontal scanning period H (time required to select one pixel row) is H milliseconds, preferably the following relationship is satisfied. Incidentally, the unit of Ic and Id is μA.
0.3≦(Ic*H)/Id≦6.0
More preferably, the following relationship is satisfied.
0.5≦(Ic*H)/Id≦5.0
More preferably, the following relationship is satisfied.
0.6≦(Ic*H)/Id≦3.0
By setting the Ic and Id currents and designing the transistor group 431 or the unit transistors 154 and 158 such that the above relationship will be satisfied, it is possible to minimize cross-talk.

For example, in the case of a QVGA panel, H=1000 (milliseconds)/(60 (Hz)*240 (pixel rows))=approximately 0.07 (millisecond). If Ic=18 (μA) and the maximum programming current Id=1 (μA), then (Ic*H)/Id=(18*0.07)/1=1.3. This satisfies the above equation.

In the case of an XGA panel, H=0.025 (milliseconds). If Ic=18 (μA) and the maximum programming current Id=1 (μA), then (Ic*H)/Id=(60*0.025)/1=1.5. This satisfies the above equation.

H is a fixed value which represents the number of pixel rows on the panel. Id is the maximum value of the programming current. It is a fixed value if the efficiency and display brightness of the EL elements on the display panel are established. Thus, Ic can be determined such that the above equation will be satisfied. For example if H=0.07 (millisecond) and Id=1 (μA), then Ic which satisfies 0.3≦(Ic*H) /Id≦6.0 is between 4 and 86 μA (both inclusive). If H=0.025 (millisecond) and Id=1 (μA), then Ic which satisfies 0.3≦(Ic*H)/Id≦8.0 is between 12 and 240 μA (both inclusive).

Although in the above example, the output stage is provided by the transistor group 431c composed of unit transistors 154, the present invention is not limited to this. Needless to say, this also applies to configurations in FIGS. 160 to 170 described later. The above items also apply to the following part of the present invention.

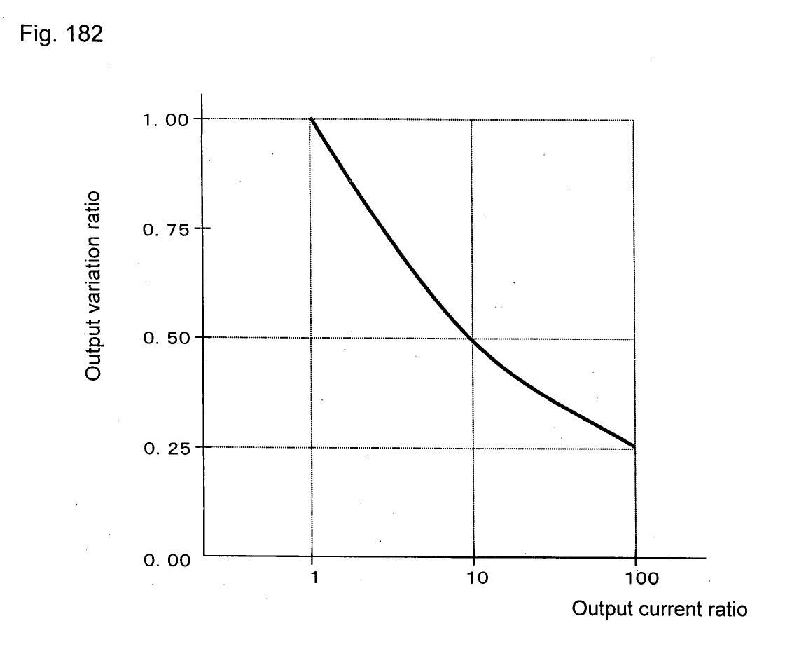

In the transistor group 431c, the magnitude of the output current is correlated with output variations. The larger the output current, the smaller the output variations. This relationship is shown in FIG. 182. When the output current is increased 10-fold, the output variations are reduced to approximately ½ (=0.5) and when the output current is increased 100-fold, the output variations are reduced to approximately ¼ (=0.25).

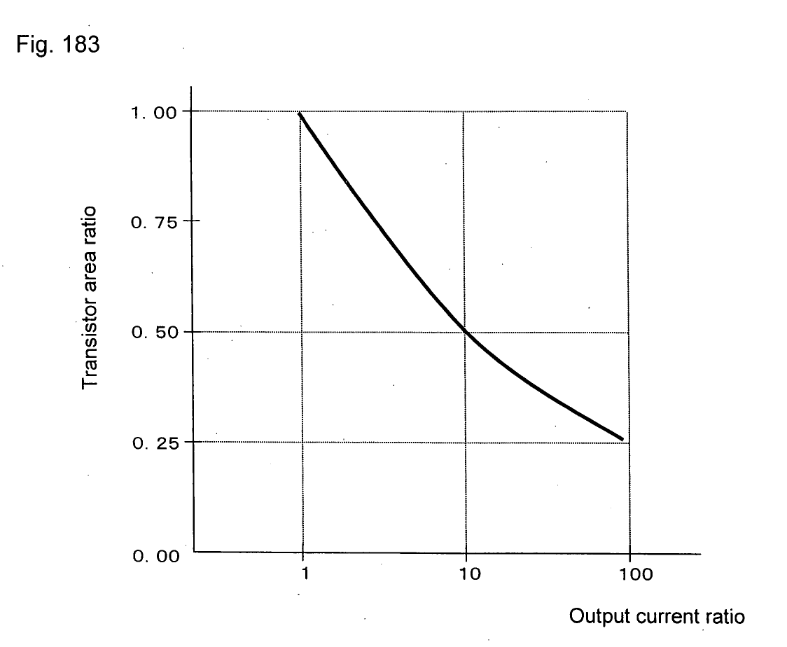

The variations in the output current is correlated with the area Sc (WL or the total area Sc of transistors which provide one output current) of the transistor (or transistor group 431c composed of unit transistors 154) in one output stage. FIG. 183 shows the above relationship, i.e., the relationship between the transistor area Sc needed to produce predetermined output variations and output current. The larger the output current, the smaller the transistor area Sc needed to produce predetermined output variations. When the output current is increased 10-fold, the transistor area Sc can be approximately ½ (=0.5). When the output current is increased 100-fold, the transistor area Sc needed to produce the predetermined output variations is reduced to approximately ¼ (=0.25).

As a result of studies according to the present invention, it is preferable that a maximum output current for an output current of one terminal is set between 0.2 μA and 20 μA (both inclusive). An output current of 0.2 μA or smaller is not practical because of large output variations. An output current of 20 μA or larger is not desirable because of large output variations: it leads to increased gate terminal voltage and decreased source terminal voltage, making it necessary to increase IC voltage resistance. Incidentally, the maximum output current is the output current for the highest gradation, which is, for example, the 255-th gradation if there are 256 gradations or the 63-rd gradation if there are 64 gradations.

As can be seen from relationships found through studies according to the present invention and shown in FIGS. 182 and 183, it is preferable to satisfy the following condition.
500≦Sc×Id≦10000
where Id (μA) is a maximum output current and Sc (square μm) is the area (WL or the total area of all the transistors which together provide one output current) of the transistor (or transistor group 431c composed of unit transistors 154) in an output stage. More preferably, the following condition should be satisfied:
800≦Sc×Id≦8000
More preferably, the following condition should be satisfied:
1000≦Sc×Id≦5000
If the above condition is satisfied, variations in output current between adjacent output terminals 155 can be reduced to 1% or less. This provides sufficient performance in practical terms.

Although in the above example, the output stage is provided by the transistor group 431c composed of unit transistors 154, the present invention is not limited to this. Needless to say, this also applies to configurations in FIGS. 160 to 170 described later. The above items also apply to the following part of the present invention.

Thus, the items described herein can be used in combination with each other or with other examples of the present invention. All the possible combinations are not described herein only because it is impossible to do so.

It has been stated with reference to FIG. 47 that the source driver ICs 14a and 14b can be cascaded properly as illustrated in FIG. 212 by adjusting the reference current Ic1 passed through the transistor 158b1 and the reference current Ic2 passed through the transistor 158b2.

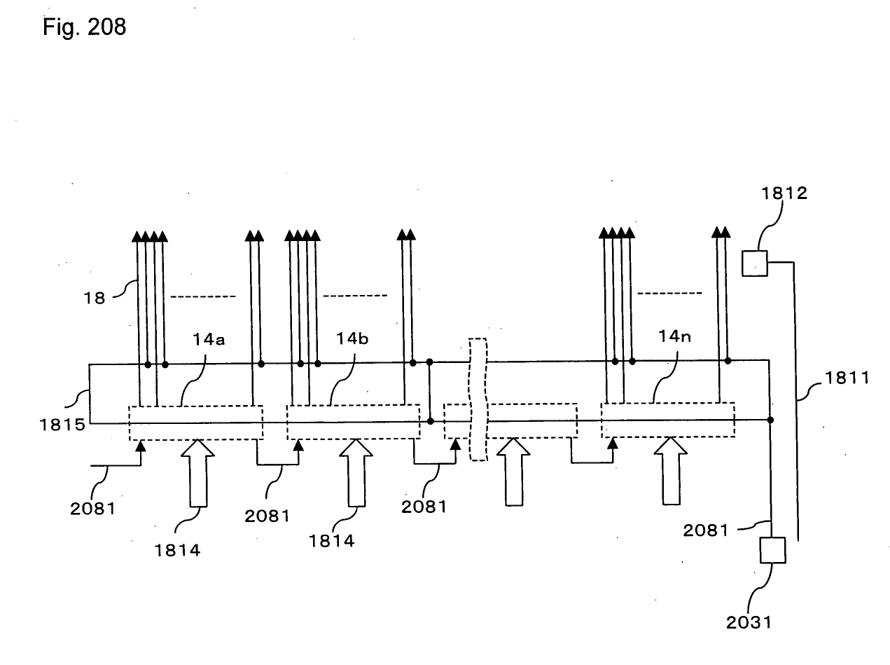

For the cascade connection, the source driver ICs 14 are connected via cascade wires 2081 as illustrated in FIG. 208. The cascade wires 2081 are laid on the array 30.

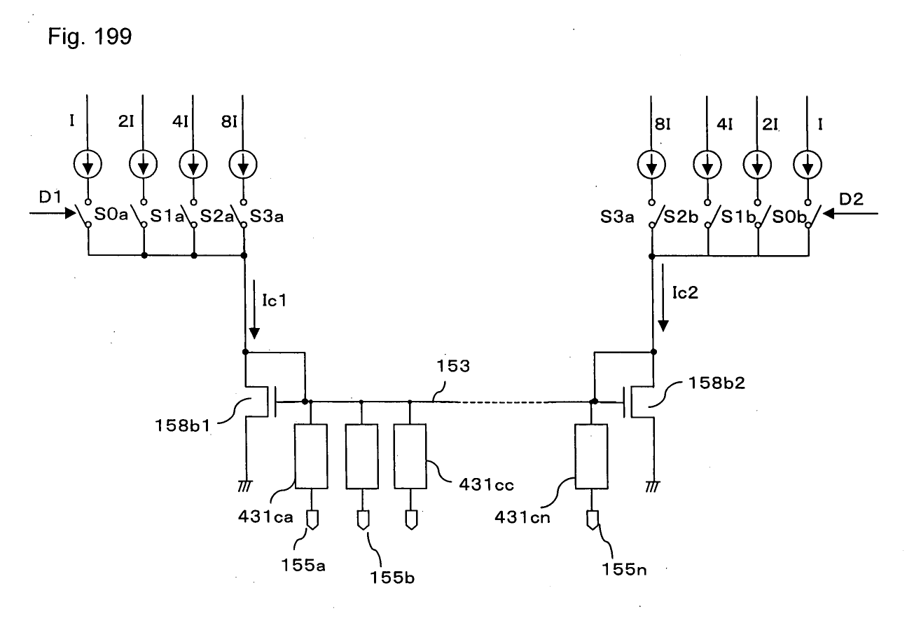

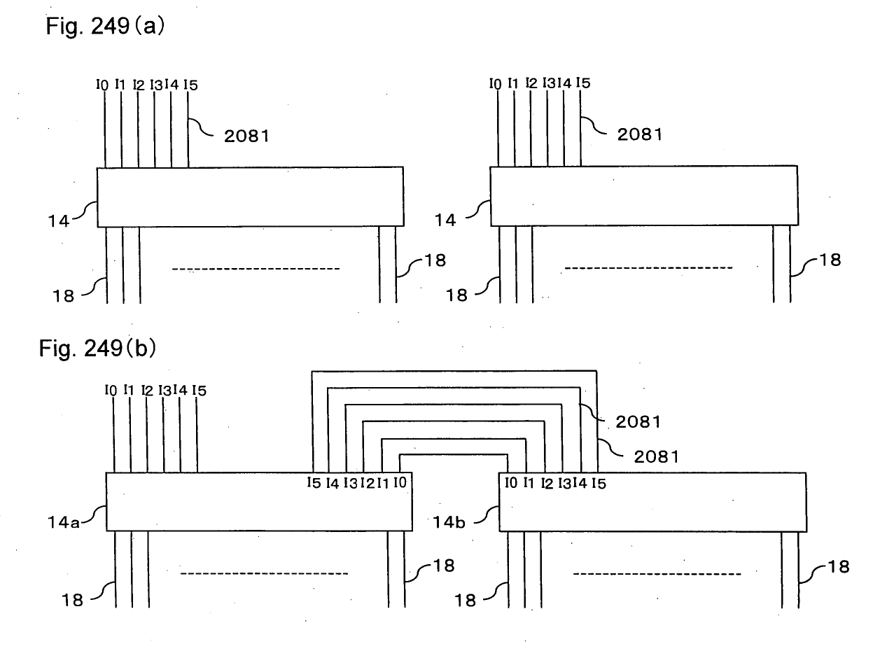

The cascade wires 2081 may be configured to input or output reference currents to/from different source driver circuits (IC) 14 separately as illustrated in FIG. 249(a) or configured to deliver the reference currents between the source driver circuit (IC) 14a and source driver circuit (IC) 14b as illustrated in FIG. 249(b). To deliver reference currents for different bits (see FIGS. 199, 230, 246, etc.) via the cascade wires 2081 as shown in FIG. 249(b), terminals (I0 to I5) are arranged in such a way as to prevent the cascade wires 2081 from crossing each other.

In FIG. 249, currents in the cascade are delivered from the source driver circuit (IC) 14a to the source driver circuit (IC) 14b. Thus, in a cascade connection, it goes without saying that currents may be delivered either between adjacent source driver circuits (IC) 14 (see FIG. 400) in sequence or from a master source driver circuit (IC) 14 to slave source driver circuits (IC). In that case, one frame or multiple frame periods can be divided and the currents in the cascade can be delivered on a time-shared basis.

To lay out cascade wires 2683 properly, source driver ICs can be configured as shown in FIG. 582, where a reference current source is placed or formed on one end of each source driver IC and a current source for cascading is placed on the other end.

The cascade wires 2081 are not limited to being formed on an array board 71. For example, cascade connections may be made via a cascade wiring pattern 2081 formed on a flexible board 1802 or printed board as illustrated in FIG. 583. When mounting source driver ICs 14 by COF technology, the source driver ICs may be cascaded by forming cascade wires 2081 on a COF film as illustrated in FIG. 584.

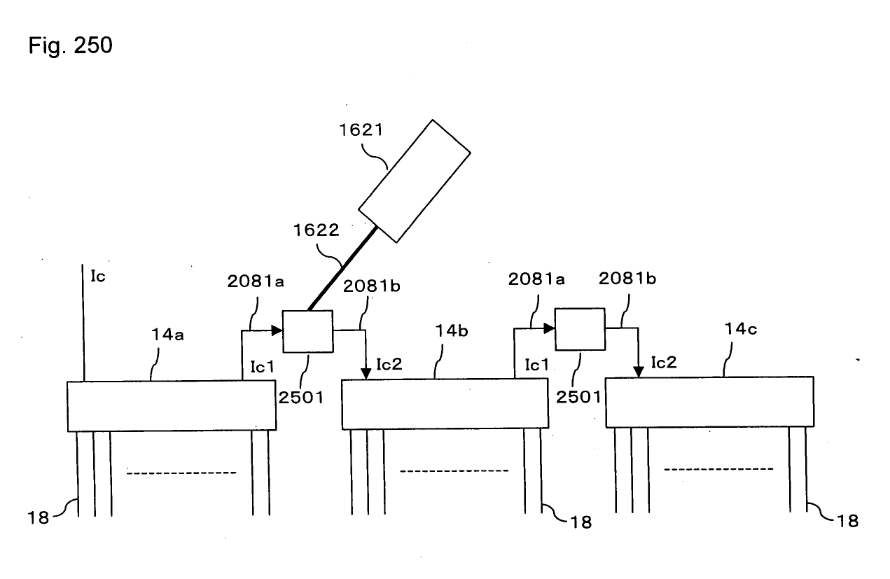

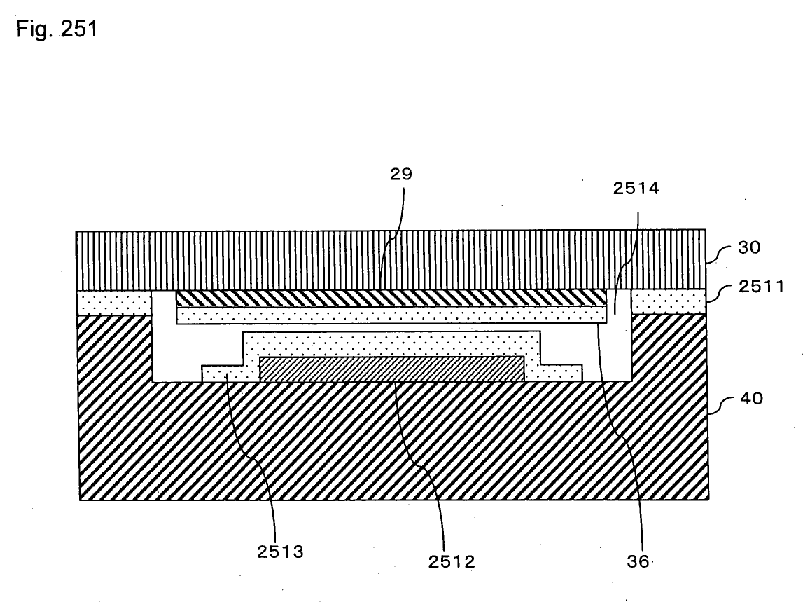

If it is necessary to adjust reference current, a trimmer-adjuster 2501 consisting of transistors and the like may be formed between cascade wires 2081a and 2081b as illustrated in FIG. 250. The trimmer-adjuster 2501 adjusts the magnitude of reference current by emitting a laser light 1622 or the like from a laser device 1621. The trimmer-adjuster 2501 may be formed in the source driver circuit (IC) 14 or formed on a substrate 30 by polysilicon technology or the like.

Accuracy is required of the reference currents delivered via a cascade connection. Thus, according to the present invention, a power source which outputs reference currents in a cascaded section makes adjustments by trimming to output predetermined reference currents. Laser trimming is used.

To achieve good cascade connection, it is sometimes necessary to measure characteristics of source driver ICs 14 after manufacturing. If characteristics can be measured, adjustment or processing can be carried out by trimming or the like. A method of measuring characteristics of the source driver circuit (IC) 14 according to the present invention will be described below. Also, it can measure (determine) variations in output current between adjacent source signal lines 18.

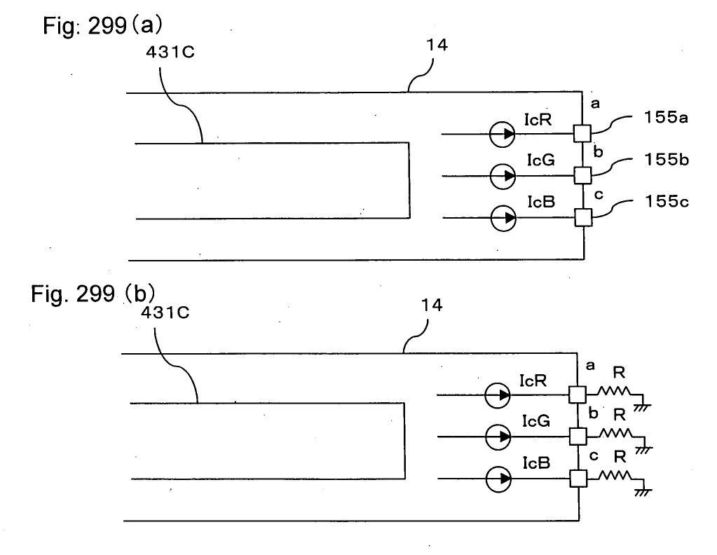

As illustrated in FIG. 299(a), the source driver circuit (IC) 14 has terminals 155 for cascade connection. A reference current IcR (for red color) for cascade connection is outputted to the terminal 155a. A reference current IcG (for green color) for cascade connection is outputted to the terminal 155b. A reference current IcB (for red color) for cascade connection is outputted to the terminal 155c. The reference currents Ic represent the characteristics of the source driver IC 14. The Smaller the reference currents Ic, the smaller the programming currents Iw. On the other hand, the larger the reference currents Ic, the larger the programming currents Iw.

Thus, by connecting resistors R of known resistance to the terminals 155 and measuring the voltages of the terminals 155 as illustrated in FIG. 299(b), it is possible to determine the particularity of the source driver IC 14. Alternatively, the reference currents Ic may be measured by connecting an ammeter directly to the terminals 155.

The above example involves measuring characteristics, etc. of the source driver circuit (IC) 14 at current output terminals of a cascaded circuit. However, the present invention is not limited to this. Terminals 155 dedicated to measuring characteristics may be formed, constructed, or placed as illustrated in FIG. 300.

In FIG. 300, transistor groups 431c (431cR (red), 431cG (green), and 431cB (blue)) for measuring characteristics are mounted next to a transistor group 431c which outputs programming currents Iw to the source signal lines 18. Since the transistor groups 431cR, 431cG, and 431cB are formed next to the transistor group 431c, they have almost the same characteristics as the latter. Thus, by connecting resistors R of known resistance to the terminals 155 and measuring the voltages of the terminals 155 (a, b, and c) as illustrated in FIG. 301(b), it is possible to determine the characteristics of the source driver IC 14.

Alternatively, the reference currents Ic maybe measured by connecting an ammeter directly to the terminals 155.

As illustrated in FIG. 301(b), needless to say, the resistors R may be incorporated in the IC chip 14. However, when the resistors R are incorporated, preferably they are trimmed to known resistance. The configuration in FIG. 301(b) allows the voltages of the terminals 155a, 155b, and 155c to be measured by setting the terminal 155d to a predetermined potential (ground potential in FIG. 301). This makes it possible to measure or predict the characteristics of the transistor groups 431c connected to the terminals 155 of the source driver IC 14. Also, the characteristics resulting from a cascade connection can be estimated, predicted, or measured.

In the example in FIG. 301, the transistor groups 431c and the like connected to the terminals 155 are measured. A similar configuration allows the performance or characteristics of a cascade connection to be evaluated. FIG. 302 shows an example of such a configuration. In FIG. 302, the resistors R are incorporated in the chip 14. The resistors R have been trimmed to predetermined resistance. As the switches S (Sa, Sb, and Sc) are closed, reference currents Ic flow into the resistors R. This makes it possible to measure the values of the reference currents Ic based on the output voltages of the terminals 155. After the measurement, the reference currents Ic (IcR, IcG, and IcB) are adjusted to predetermined values.

The source driver circuit (IC) 14 according to the present invention can prescribe RGB white balance and adjust it to a predetermined value by adjusting the reference currents Ic to predetermined values. Also, since the programming currents Iw can be adjusted to predetermined values, the display brightness of images can be adjusted to predetermined values as well. Thus, it is very important to set the reference currents Ic to predetermined values.

To solve this problem, the present invention has electronic regulators 501 to adjust the R, G, and B reference currents separately as illustrated in FIG. 303. Also, it has a flash memory 3031 to set the reference currents Ic to predetermined values by adjusting and fixing the values of the electronic regulators 501. By rewriting FDATA (FDATAR, FDATAG, and FDATAB) into the flash memory 3031, it is possible to fix or temporarily hold the values of the electronic regulators 501 (501R, 501G, and 501B). Thus, the reference currents Ic (IcR, IcG, and IcB) can be adjusted easily to predetermined values. Target values for adjustment may be determined by measuring the reference currents Ic directly or by measuring the display brightness of the display screen 144 as illustrated in FIG. 306.

Although it has been stated with reference to FIG. 303 that target values of the reference currents Ic are obtained by adjusting the electronic regulators 501 to predetermined values using the flash memory 3031, the present invention is not limited to this. For example, the reference currents Ic may be adjusted using external regulators VR (VR1 for red, VR2 for green, and VR3 for blue) as illustrated in FIG. 304. Needless to say, the reference currents Ic (IcR, IcG, and IcB) flowing through the transistors 158 (see FIGS. 58, 59, 60, etc.) may be adjusted on current sources I (Ia, Ib, and Ic) as illustrated in FIG. 305.

It has been stated with reference to FIG. 47 that the reference currents Ic1 and Ic2 are adjusted. However, if the gate wiring 153 has resistance higher than a predetermined value, slopes of output currents are corrected, as shown in FIG. 47, even if the reference current Ic1 passed through the transistor 158b1 and the reference current Ic2 passed through the transistor 158b2 are equal.

For ease of understanding, description will be provided citing concrete figures. Suppose Ic1=Ic2=10 (μA). Also, it is assumed that the gate terminal voltage V1 of the transistor 158b1=0.60 (V) and that the gate terminal voltage V2 of the transistor 158b2=0.61 (V). The difference between the reference current flowing through the transistor 158b1 and reference current flowing through the transistor 158b2 must be kept within 1%, and 1% of the reference current, which is 10 μA, is 0.1 μA. Therefore, (V2−V1)/0.1 (μA)=(0.61−0.60) (V)/0.1 (μA)=100 (KΩ). Thus, if the resistance of the gate wiring 153 is set to 100 (KΩ), the slopes of output currents are adjusted and the difference between the output currents of adjacent ICs 14 are kept within 1%.

The higher the resistance of the gate wiring 153, the smaller the correction current Id can be. However, too high resistance of the gate wiring 153 will increase the wave height of linking in FIG. 52, resulting in marked horizontal cross-talk. Thus, there is an appropriate range of resistance for the gate wiring 153.

The present invention is characterized in that all or at least part of the gate wiring 153 is made of polysilicon. Preferably, the gate wiring 153 is made of polysilicon except at or near the points of contact with the gate terminals of unit transistors 154. The gate wiring 153 is configured to have desired resistance by adjusting its width or by meandering it.

Linking of the gate wiring 153 can be reduced by reducing the resistance of the gate wiring 153 to or below a predetermined value, by increasing the total area Sb of the transistors 158b (or total area Sb of the transistor group 431b), or by increasing the reference current Ic.

Let S0 denote the area of unit transistors 154 per output (the total area of unit transistors 154 in one transistor group 431c) and let Sb denote the total area of the transistors 158b in the transistor group 431b (or the total area of the transistors 158b in the transistor groups 431b if there are a plurality of transistor groups 431b as in the case of FIG. 44).

FIG. 71 shows a relationship between Sb/S0 represented by the horizontal axis and allowable gate wiring resistance (KΩ) represented by the vertical axis. An allowable range (range in which the gate wiring 153 is not subject to linking) corresponds to the area below the solid line in FIG. 71. In other words, this is a range in which horizontal cross-talk is allowable in practical terms.

The horizontal axis in FIG. 71 represents the total size Sb of the transistor groups 431b in relation to the size S0 of unit transistors 154 per output (63 unit transistors 154 if there are 64 gradations). If S0 is a fixed value, the allowable resistance of the gate wiring 153 increases with increases in Sb. This is because the impedance of the gate wiring 153 decreases with increases in Sb, resulting in increased stability.

Due to the need to reduce output variations to or below a certain level while generating required output current (programming current), S0 has a narrow design range. On the other hand, there are design constraints to set the resistance of the gate wiring 153 to a predetermined value.

Increasing the resistance of the gate wiring 153 involves a problem of reduced wire width, resulting in a broken wire as well as a problem of stability. Also, increases in Sb increase the chip area, resulting in high costs. Thus, from the viewpoint of IC 14 size, it is preferable that Sb/S0 is 50 or less. Also, due to the problem of linking and other constraints, it is preferable that Sb/S0 is 5 or more for stable design of gate wiring 153. Thus, the relationship 5≦Sb/S0≦50 should be satisfied.

As can be seen from the graph (solid line) in FIG. 71, the smaller the ratio Sb/S0, the more gentle the slope of the solid curve. When Sb/S0 is 15 or more, the slope tends to become constant. Thus, when Sb/S0 is between 5 and 15 (both inclusive), the resistance of the gate wiring 153 should be 400 KΩ or less. When Sb/S0 is between 15 and 50 (both inclusive), the resistance should be Sb/S0×24 (KΩ) or less. For example, when Sb/S0=50, the resistance should be 50×24=1200 (KΩ) or less.

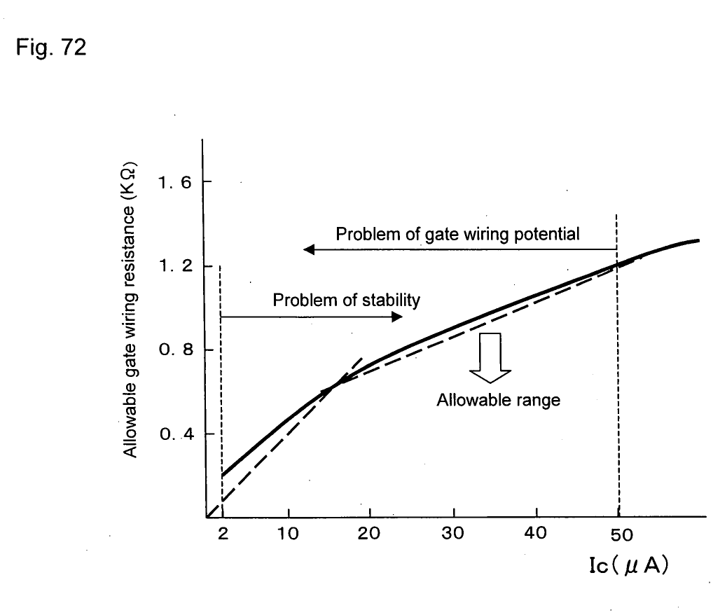

There is a correlation between the reference current Ic flowing through the transistors 158b and allowable gate wiring resistance. This is because the larger the reference current Ic, the lower the impedance when the gate wiring 153 is viewed from the transistors 158b. This relationship is shown in FIG. 72. In FIG. 72, the horizontal axis represents the reference current Ic (μA) flowing through the transistors 158b (or transistor group 431b) while the vertical axis represents allowable gate wiring resistance (KΩ). The area below the solid line in FIG. 72 is an allowable range (range in which the gate wiring 153 is not subject to linking). In other words, this is a range in which horizontal cross-talk is allowable in practical terms.

Increasing the reference current Ic improves the stability of the gate wiring 153. However, this increases the amount of reactive current consumed by the source driver IC 14 and raises the potential of the gate wiring 153. In view of this, the reference current Ic should be equal to 50 (μA) or less.

Decreasing the reference current Ic lowers the stability of the gate wiring 153. Thus, the resistance of the gate wiring 153 must be lowered. However, a reference current lower than a certain level increases variations in the output currents of the unit transistors 431c, decreasing the stability of the output currents. In view of this, the reference current Ic should be equal to 2 (μA) or more. Thus, the reference current Ic passed through the transistors 158b should be between 2 and 50 μA (both inclusive).

The graph (solid line) in FIG. 72 can be approximated by two straight lines. When Ic is between 2 and 15 μA (both inclusive), the resistance (MΩ) of the gate wiring 153 should be 0.04×Ic (MΩ) or below. For example, if Ic=15 (μA), the resistance of the gate wiring 153 should be 0.6 (=0.04×15) MΩ or below.

When Ic is between 15 and 50 μA (both inclusive), the resistance (MΩ) of the gate wiring 153 should be 0.25 ×Ic (MΩ) or below. For example, if Ic=50 (μA), the resistance of the gate wiring 153 should be 0.025×50=1.25(MΩ) or below.

There is also a correlation between the period during which one pixel row is selected (one horizontal scanning period (1 H)) and resistance R (KΩ) of the gate wiring 153 multiplied by the length D (m) of the gate wiring 153. That is, the shorter the 1H period, the shorter the time allowed for the potential of the gate wiring 153 to return to its normal value. Also, as shown in FIG. 47, with increases in the length D (=the length of the driver IC chip) of the gate wiring 153, potential fluctuations of the unit transistor group 431c farthest from the transistor 158b go out of an allowable range.

It is presumed that this phenomenon is caused by parasitic capacitance existing between the unit transistors 154 and source signal lines 18. This means that as the chip length D of the driver IC 14 increases, it becomes necessary to take into consideration not only the resistance of the gate wiring 153, but also potential fluctuations of the gate wiring 153 caused by parasitic capacitance.

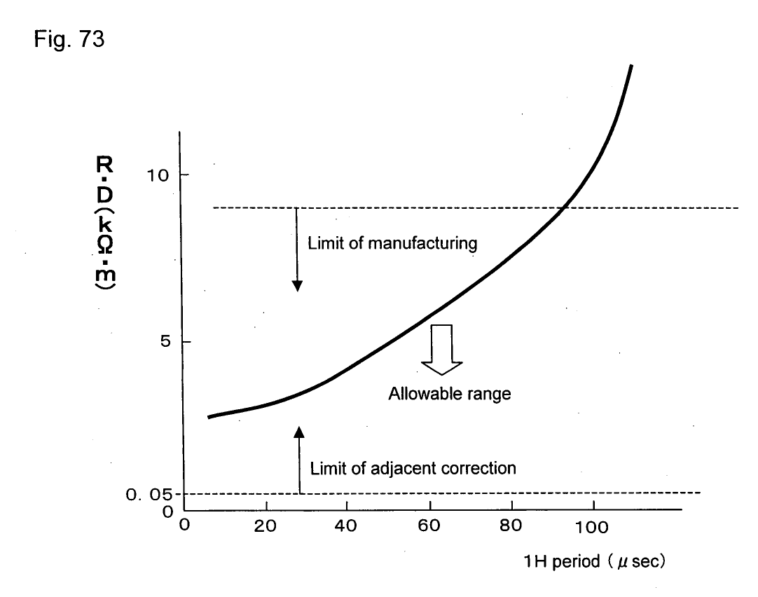

In FIG. 73, the horizontal axis represents one horizontal scanning period (μsec) while the vertical axis represents the product of gate wiring resistance (KΩ) and chip length D (m). The area below the solid line in FIG. 73 is an allowable range. An R*D value of 9 (KΩ*m) corresponds to a limit of manufacturing for the source driver IC. Above this limit, the source driver IC becomes too expensive to be practical. On the other hand, if R*D is 0.05 or below, the current Id becomes too large, and so do differences between adjacent output currents. Thus, R*D should be between 0.05 and 9 (both inclusive).

If P-channel transistors are used as the transistors 11 of pixels 16, programming current flows in the direction from the pixels 16 to the source signal lines 18. Thus, N-channel transistors should be used as the unit transistors 154 of the source driver circuits (see FIGS. 15, 57, 58 and 59). That is, the source driver circuits (IC) 14 should be configured in such a way as to draw the programming current Iw.

If the driver transistors 11a of the pixels 16 (in the case of FIG. 1) are P-channel transistors, the unit transistors 154 must be N-channel transistors to ensure that the source driver circuits (IC) 14 will draw the programming current Iw.

In order to form a source driver circuit (IC) 14 on an array board 30, it is necessary to use both mask (process) for N-channel transistors and mask (process) for P-channel transistors. Conceptually speaking, in the display panel (display apparatus) of the present invention, P-channel transistors are used for the pixels 16 and gate driver circuits 12 while N-channel transistors are used as the transistors of drawing current sources of the source drivers According to an embodiment of the present invention, P-channel transistors are used as the transistors 11 of pixels 16 and for the gate driver circuits 12. This makes it possible to reduce the costs of substrates 30.

However, in the source driver circuits (IC) 14, unit transistors 154 must be N-channel transistors. Thus, the source driver circuits (IC) 14 cannot be formed directly on a substrate 30 if only the process for P-channel transistors is used. Thus, the source driver circuits (IC) 14 are made of silicon chips and the like separately and mounted on the substrate 30. In short, the present invention is configured to mount source driver ICs 14 (means of outputting programming current as video signals) externally.

N-channel unit transistors 154 have 70% as large variations as P-channel unit transistors 154 when they have the same area. That is, N-channel unit transistors 154 cause smaller variations than P-channel unit transistors if their formation areas are equal. Results of study indicate that a formation area twice larger than that of N-channel unit transistors is required of P-channel unit transistors to reduce their variations to the same level as N-channel unit transistors (see FIG. 159).

Although it has been stated that the source driver circuits (IC) 14 are made of silicon chips, this is not restrictive. For example, a large number of source driver circuits may be formed on a glass substrate simultaneously using low-temperature polysilicon technology or the like, cut off into chips, and mounted on a board 30.

Incidentally, although it has been stated that source driver circuits are mounted on a board 30, this is not restrictive. Any form may be adopted as long as the output terminals 431 of the source driver circuits (IC) 14 are connected to the source signal lines 18 of the board 30. For example, the source driver circuits (IC) 14 may be connected to the source signal lines 18 using TAB technology. By forming source driver circuits (IC) 14 on a silicon chip separately, it is possible to reduce variations in output current and achieve proper image display as well as to reduce costs.

The configuration in which P-channel transistors are used as selection transistors of pixels 16 and for gate driver circuits is not limited to organic EL or other self-luminous devices (display panels or display apparatus). For example, it is also applicable to liquid crystal display panels and FEDs (field emission displays).

If the switching transistors 11b and 11c of a pixel 16 are P-channel transistors, the pixel 16 becomes selected at Vgh, and becomes des elected at Vgl. As described earlier, when the gate signal line 17a changes from Vgl (on) to Vgh (off), voltage penetrates (penetration voltage). If the driver transistor 11a of the pixel 16 is a P-channel transistor, the penetration voltage restricts the flow of current through the transistor 11a in black display mode. This makes it possible to achieve a proper black display. The problem with the current-driven system is that it is difficult to achieve a black display.

According to the present invention, which uses P-channel transistors for the gate driver circuits 12, the turn-on voltage corresponds to Vgh. Thus, the gate driver circuits 12 match well with the pixels 16 constructed from P-channel transistors. Also, to improve black display, it is important that the programming current Iw flows from the anode voltage Vdd to the unit transistors 154 of the source driver circuits (IC) 14 via the driver transistors 11a and source signal lines 18, as is the case with the pixel 16 configuration shown in FIGS. 1, 2, 6, 7, and 8.

Thus, a good synergistic effect can be produced if P-channel transistors are used for the gate driver circuits 12 and pixels 16, the source driver circuits (IC) 14 are mounted on the substrate, and N-channel transistors are used as the unit transistors 154 of the source driver circuits (IC) 14.

Besides, unit transistors 154 constituted of N-channel transistors have smaller variations in output current than unit transistors 154 constituted of P-channel transistors. N-channel unit transistors 154 have 1/1.5 to ½ as large variations in output current as P-channel unit transistors 154 when they have the same area (W·L). For this reason, it is preferable that N-channel transistors are used as the unit transistors 154 of the source driver IC 14.

The same applies to FIG. 42(b). FIG. 42(b) shows a configuration in which a programming current Iw flows from an anode voltage Vdd to the unit transistors 154 of a source driver circuit (IC) 14 via a programming transistor 11a and source signal line 18 rather than a configuration in which current flows into the unit transistors 154 of a source driver circuit (IC) 14 via a driver transistor 11b.

Thus, as in the case of FIG. 1, a good synergistic effect can be produced if P-channel transistors are used for the gate driver circuits 12 and pixels 16, the source driver circuits (IC) 14 are mounted on the substrate, and N-channel transistors are used as the unit transistors 154 of the source driver circuits (IC) 14.

According to the present invention, the driver transistors 11a of the pixels 16 are P-channel transistors and the switching transistors 11b and 11c are P-channel transistors. Also, the unit transistors 154 in the output stages of the source driver circuits 14 are N-channel transistors. Besides, preferably P-channel transistors are used for the gate driver circuits 12.

Needless to say, a configuration as interchanged also works well. Specifically, the driver transistors 11a of the pixels 16 are N-channel transistors and the switching transistors 11b and 11c are N-channel transistors. Also, the unit transistors 154 in the output stages of the source driver circuits 14 are P-channel transistors. Besides, preferably N-channel transistors are used for the gate driver circuits 12. This configuration also belongs to the present invention.

Next, a precharge circuit will be described. As described earlier, in the case of current driving, only a small current is written into pixels during black display. Consequently, if the source signal lines 18 or the like have parasitic capacitance, current cannot be written into the pixels 16 sufficiently during one horizontal scanning period (1 H). Generally, in current-driven light-emitting elements, black-level current is as weak as a few nA, and thus it is difficult to drive parasitic capacitance (load capacitance of wiring) which is assumed to measure tens of pF using the signal value of the black-level current.

To solve this problem, it is useful to equalize the black-level current in the pixel transistors 11a (basically, the transistors 11a are off) with the potential level of the source signal lines 18 by applying a precharge voltage (synonymous or roughly synonymous with programming voltages) before writing image data into the source signal lines 18. In order to form (create) the precharge voltage (synonymous or roughly synonymous with programming voltages), it is useful to output the black level at a constant voltage by decoding higher order bits of image data.

Precharging is a method of applying a voltage forcibly to source signal lines 18 at the beginning of 1 H or the like. The voltage turns off the driver transistors 11a (although the configuration in FIG. 1 is cited, this is not restrictive and the method is also applicable to voltage-driven pixel configurations) If the driver transistors 11a are P-channel transistors, a voltage close to the anode voltage is applied. That is, the applied voltage acts as a turn-off voltage. If the driver transistors 11a are N-channel transistors, a voltage close to the cathode voltage is applied.

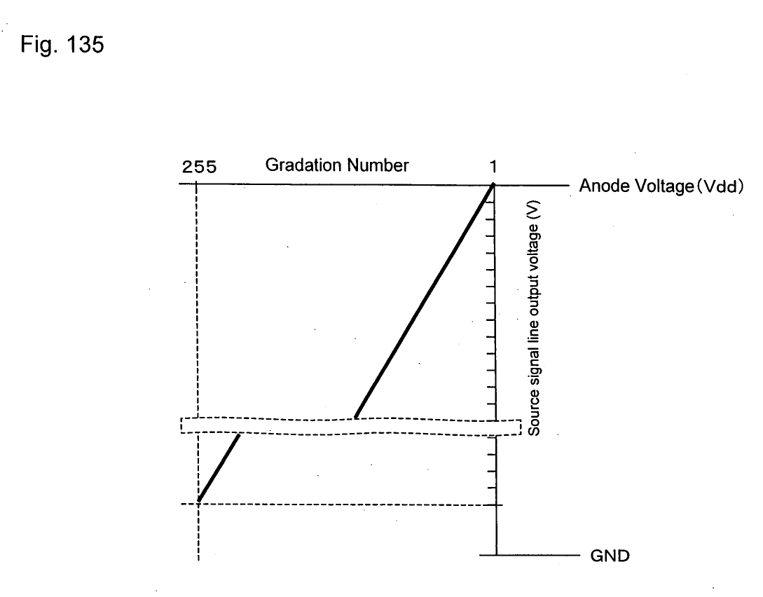

Precharging consists in applying a voltage (not higher than a start-up current) which turns off the driver transistors 11a or brings them close to an OFF state. If a plurality of precharge voltages (synonymous or roughly synonymous with programming voltages) are used as in the case of FIGS. 135 to 139 (low-gradation precharge driving), the voltages are applied to the gate terminals (G) of the driver transistors 11a and the output currents of the driver transistors 11a are varied (controlled) according to the applied voltages. Precharge driving consists in writing a black level voltage into the pixel transistors 11a. Also, it is a drive method which cuts off the pixel transistors 11a. Besides, it writes a current for use by the transistors 11a to turn off the terminal voltage of capacitors 11a.

Thus, application of the precharge voltage (synonymous or roughly synonymous with programming voltages) is the method of applying the voltage which turns off the driver transistors la forcibly. Also, the precharge voltage is applied to the source signal lines 18 for forcible charging and discharging.

Although application of the precharge voltage (synonymous or roughly synonymous with programming voltages) has been described above, the potential of the source signal lines 18 can be varied not only by the application of a voltage, but also by the application of a current (charging and discharging). Thus, the technical idea of applying a precharge voltage (synonymous or roughly synonymous with programming voltages) also includes application of a precharge current.

The precharge voltage (synonymous or roughly synonymous with programming voltages) (current) may be applied not only once in a horizontal scanning period, but also multiple times in a horizontal scanning period. Needless to say, the precharge voltage may be applied once in multiple horizontal scanning periods, once in a frame or field period, or once or multiple times in multiple fields or one frame.

When applying precharge voltage multiple times in one horizontal scanning period or one frame, needless to say the magnitude of the precharge voltage (synonymous or roughly synonymous with programming voltages) may be varied among the multiple times or the application duration of the precharge voltage may be varied among the multiple times. Also, the point of application (e.g., both ends or the center of the source signal line 18) may be varied. It may be varied every frame or every horizontal scanning period.

The present invention is characterized in that the driver transistors are P-channel transistors and that the precharge voltage (synonymous or roughly synonymous with programming voltages) is lower than the anode voltage Vdd (i.e., the anode voltage Vdd minus 1.5 V). Also, a precharge voltage (synonymous or roughly synonymous with programming voltages) different from other precharge voltages is used for at least one of R, G, and B. For example, the configuration shown in FIG. 75 is provided in the source driver IC 14 for each of R, G, and B.

Although it is stated herein that R, G, and B output circuits (output circuits of programming currents (programming voltages)) are provided in a single source driver circuit (IC) 14, this is not restrictive. For example, three source driver circuits (IC) 14 may be installed on a single array board 30 or the like to produce separate R, G, and B outputs. Also, the precharge circuit configuration illustrated in FIG. 75, etc. is placed in each of the R, G, and B IC chips (circuits) 14. The present invention is not limited to placing three precharge circuits and the like for R, G, and B in a single source driver circuit (IC) 14. It is sufficient to provide one or more of R, G, and B precharge circuits. This is because there are EL elements 15 which can achieve proper black display even if all of the R, G, and B pixels are not precharged.

Regarding the precharge voltage, a fixed voltage may be divided into multiple precharge voltages as illustrated in FIG. 558. In FIG. 558, a voltage Vp is divided by resistors R and the resulting voltages have their impedance lowered through the operational amplifier 502 to generate precharge voltages Vp1 and Vp2. One of the precharge voltages (Vp1 and Vp2) is selected according to image data and outputted through the terminal 155. The selection of the output voltage is made by switches 151a and 151b.

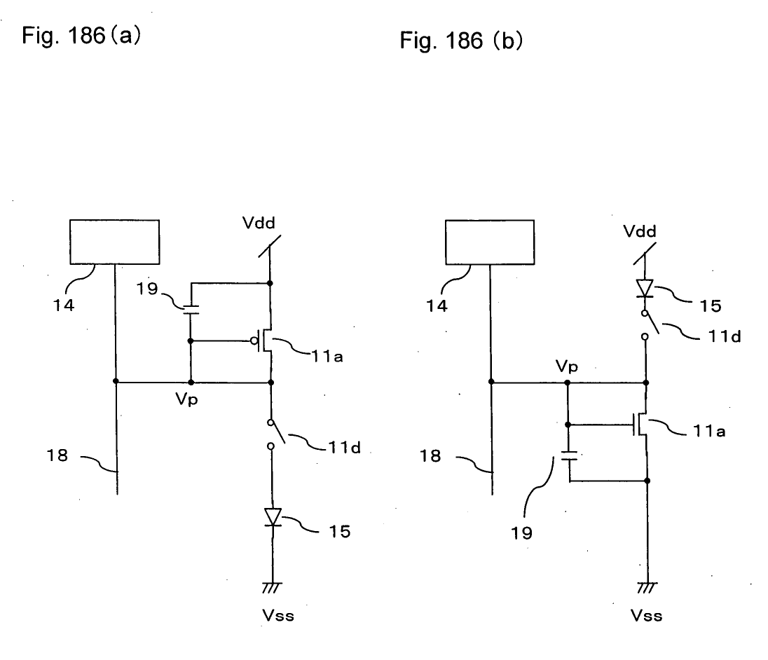

FIG. 186 is an explanatory diagram illustrating precharge driving. FIG. 186(a) shows a case in which the driver transistor 11a is a P-channel transistor. Although the pixel configuration in FIG. 1 is cited, this is not restrictive. Needless to say, this method is also applicable to EL display panels or EL display apparatus with other pixel configurations such as those shown in FIGS. 2, 7, 11, 12, 13, 28, and 31.

The precharge voltage (synonymous or roughly synonymous with programming voltages) is generated by the source driver circuit (IC) 14. This is also a feature of the present invention. The source driver circuit (IC) 14 consists of a silicon chip. When the driver transistor 11a is a P-channel transistor, the precharge voltage (synonymous or roughly synonymous with programming voltages) is not higher than Vdd and not lower than Vdd−5.0 (V). The precharge voltage (synonymous or roughly synonymous with programming voltages) Vp is applied to either both the gate terminal and drain terminal or the gate terminal of the driver transistor 11a when the pixel selection transistor 11c turns on.

The precharge voltage (synonymous or roughly synonymous with programming voltages) turns off the driver transistor 11a (so that current does not flow) The transistor 11d of the pixel to which the precharge voltage (synonymous or roughly synonymous with programming voltages) is applied is turned off so that the precharge voltage (synonymous or roughly synonymous with programming voltages) will not be applied to the EL element 15. Consequently, the precharge voltage (synonymous or roughly synonymous with programming voltages) does not cause the EL element 15 to emit light unnecessarily.

FIG. 186(b) shows a case in which the driver transistor 11a is an N-channel transistor. The precharge voltage (synonymous or roughly synonymous with programming voltages) is generated by the source driver circuit (IC) 14. When the driver transistor 11a is an N-channel transistor, the precharge voltage (synonymous or roughly synonymous with programming voltages) is not lower than Vss and-not higher than Vss+5.0 (V).

The precharge voltage (synonymous or roughly synonymous with programming voltages) Vp is applied to either both the gate terminal and drain terminal or the gate terminal of the driver transistor 11a when the pixel selection transistor 11c turns on. The precharge voltage (synonymous or roughly synonymous with programming voltages) turns off the driver transistor 11a (so that current does not flow). The transistor 11d of the pixel to which the precharge voltage (synonymous or roughly synonymous with programming voltages) is applied is turned off so that the precharge voltage (synonymous or roughly synonymous with programming voltages) will not be applied to the EL element 15. Consequently, the precharge voltage (synonymous or roughly synonymous with programming voltages) does not cause the EL element 15 to emit light unnecessarily.

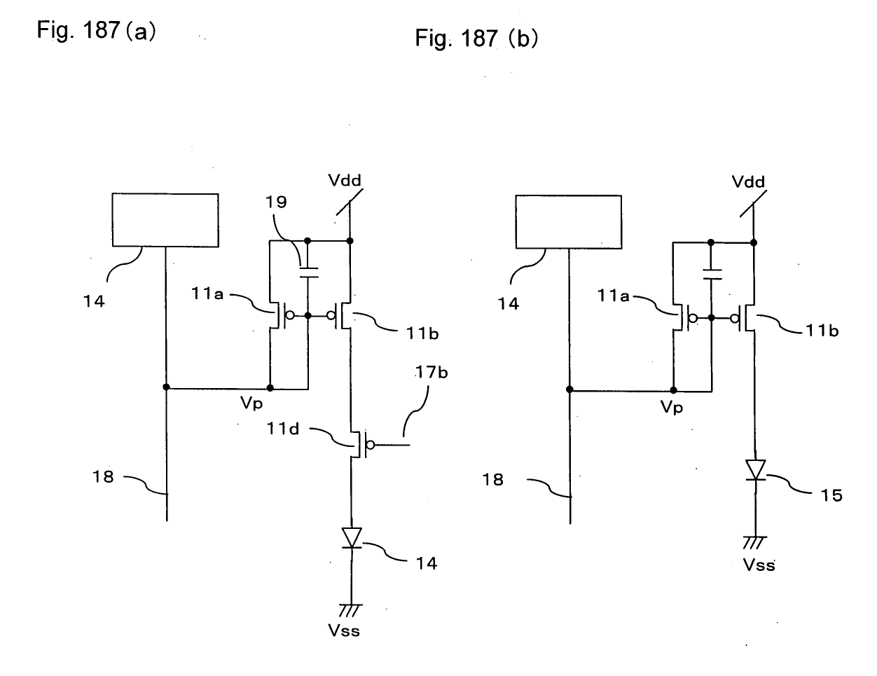

FIG. 187(a) shows a case in which a current-mirror pixel configuration is used as in the case of FIG. 13. The driver transistor 11b is a P-channel transistor. The precharge voltage (synonymous or roughly synonymous with programming voltages) is generated by the source driver circuit (IC) 14. When the driver transistor 11a is a P-channel transistor, the precharge voltage (synonymous or roughly synonymous with programming voltages) is not higher than Vdd and not lower than Vdd−5.0 (V). The precharge voltage (synonymous or roughly synonymous with programming voltages) Vp is applied to either both the gate terminal and drain terminal or the gate terminal of the driver transistor 11a when the pixel selection transistor 11c turns on.

The precharge voltage (synonymous or roughly synonymous with programming voltages) turns off the driver transistor 11a (so that current does not flow). The transistor 11d of the pixel to which the precharge voltage is applied is turned off so that the precharge voltage will not be applied to the EL element 15. Consequently, the precharge voltage does not cause the EL element 15 to emit light unnecessarily.

As illustrated in FIG. 187(b), the transistor 11b is not strictly necessary. The transistor 11b is unnecessary especially in the case of a current-mirror pixel configuration such as the one shown in FIG. 13. Also, it goes without saying that the driver transistor 11b in FIG. 187 may be an N-channel transistor as in the case of FIG. 186(b).

An example of precharge driving is illustrated in FIGS. 565 to 568. Preferably, the precharge voltage is freely configurable with an electronic regulator or the like.

In FIGS. 565 to 569, the top graph shows the potential of a source signal line 18 to which no precharge voltage is applied. The driver transistor of the pixel 16 is a P-channel transistor. For ease of understanding, it is assumed that pixel data represents 64 gradations. Thus, the precharge voltage (PRV) is close to the anode voltage (Vdd). The precharge voltage (PRV) is applied so that no current or little current will flow through the driver transistor. This puts the pixel 16 in black display mode. If the driver transistor is an N-channel transistor, a voltage close to the ground (GND) potential or cathode voltage (Vss) is applied as the precharge voltage so that no current will flow through the driver transistor.

The foregoing is a method of putting a pixel in black display mode or in a state close to black display mode by the application of a precharge voltage. However, there are cases in which pixels are put in white display mode by the application of a precharge voltage. Thus, the precharge voltage is applied not only to make pixels display black, but also to set the source signal line 18 to a predetermined potential.

When the driver transistor 11a of the pixel 16 is a P-channel transistor as in the case of FIG. 1, etc., it is important that the switching transistor 11b is also a P-channel transistor. This is because the penetration voltage produced when the switching element 11b turns off makes black display easier. Accordingly, when the driver transistor 11a of the pixel 16 is an N-channel transistor, it is important that the switching transistor 11b is also an N-channel transistor. This is because the penetration voltage produced when the switching element 11b turns off makes black display easier.

The bottom graph illustrates the potential of the source signal line 18 to which the precharge voltage (PRV) is applied. The arrows indicate points at which the precharge voltage (PRV) is applied. The points of application of precharge voltage are not limited to the beginning of 1 H. The precharge voltage can be applied within the first ½ H. Incidentally, when the precharge voltage is applied to the source signal line 18, preferably all gate signal lines 17a are kept des elected by the operation of an OEV terminal of the selection-side gate driver 12a.

FIG. 565 shows ALL precharge mode. The precharge voltage (PRV) is applied to the source signal line at the beginning of 1 H. When the precharge voltage (PRV) is applied to the source signal line 18, a black display voltage is applied to the source signal line 18 for a moment.

FIG. 566 shows the potential of the source signal line in selective precharge mode, in which the precharge voltage is applied only for the 0th gradation (completely black display).

FIG. 567 shows the potential of the source signal line in selective precharge mode, in which the precharge voltage is applied in the case of the 8th or lower gradation.

Further, FIG. 568 shows adaptive precharge mode. When performing precharging only for the 0th gradations, if the 0th gradation occurs consecutively, once precharging is performed, no precharging is performed for the consecutive 0th gradations. In adaptive precharge mode in FIG. 568, when performing selective precharging for the eighth and higher gradations, if the eighth or higher gradations occur consecutively, once precharging is performed, no precharging is performed for the consecutive eighth or higher gradations.

In the case of current driving (current programming), the currents flowing through the source signal lines 18 are small. This puts the source signal lines 18 in a floating state, sometimes making their potentials unpredictable. A possible method of dealing with the situation involves stabilizing the potentials of the source signal lines 18 by applying a precharge voltage to the source signal lines 18.

FIG. 569 shows an example in which the potentials of the source signal lines 18 are stabilized by the application of a precharge voltage. The precharge voltage is applied to the source signal lines 18 all at once at the end or beginning of one field or frame. FIG. 570 shows a variation. In the first field, the precharge voltage is applied to the odd-numbered source signal lines 18 and in the second field, the precharge voltage is applied to the even-numbered source signal lines 18.

Preferably the precharge voltage is applied earlier than a display period by 1 H or more as illustrated in FIG. 571. In FIG. 571, precharging is performed before B reaches 2 Hs (two horizontal scanning periods). This is because precharging, if performed immediately before a display period, can change the potentials of the source signal lines 18 greatly, which may cause adverse effect, namely, a reduction in the brightness of the first pixel row in image display.

FIG. 75 shows an example of a current-output type source driver IC (circuit) 14 equipped with a precharge function according to the present invention. FIG. 75 shows a case in which the precharge function is provided in the output stage of a 6-bit constant-current output circuit 164.

In FIG. 75, any precharge voltage supplied is applied to point B on internal wiring 150. Thus, it is applied to the current output stage 164 as well. However, since the current output stage 164 constitutes a constant-current circuit, it has high impedance. Thus, even if the precharge voltage is applied to the current output stage 164, there is no problem with circuit operation.

Although precharging may be performed over the entire range of gradations, preferably precharging should be limited to a black display region. Specifically, precharging is performed by selecting gradations in a black region (low brightness region, in which only a small (weak) current flows in the case of current driving) from write image data (hereinafter, this type of precharging will be referred to as selective precharging). If precharging is performed over the entire range of gradations, brightness lowers (a target brightness is not reached) in a white display region. Also, vertical streaks may be displayed in some cases.

Preferably, selective precharging is performed for ⅛ of all the gradations beginning with the 0th gradation (e.g., in the case of 64 gradations, image data is written after precharging for the 0th to 7th gradations). More preferably, selective precharging is performed for 1/16 of all the gradations beginning with the 0th gradation (e.g., in the case of 64 gradations, image data is written after precharging for the 0th to 3rd gradations).

A method which performs precharging by detecting only the 0th gradation is also effective in enhancing contrast, especially in black display. It achieves an extremely good black display. The method of performing precharging by extracting only the 0th gradation causes little harm to image display. Thus, it is most preferable to adopt this method as a precharging technique.

It is also useful to vary the precharge voltage and gradation range among R, G, and B because emission start voltage and emission brightness of EL elements 15 vary among R, G, and B. For example, selective precharging is performed for ⅛ of all the gradations beginning with the 0th gradation (e.g., in the case of 64 gradations, image data is written after precharging for the 0th to 7th gradations) in the case of R. In the case of other colors (G and B), selective precharging is performed for 1/16 of all the gradations beginning with the 0th gradation (e.g., in the case of 64 gradations, image data is written after precharging for the 0th to 3rd gradations). Regarding the precharge voltage, if 7 V is written into the source signal lines 18 for R, 7.5 V is written into the source signal lines 18 for the other colors (G and B).

Optimum precharge voltage often varies with the production lot of the EL display panel. Thus, preferably precharge voltage can be adjustable with an external regulator. Such a regulator circuit can be implemented easily using an electronic regulator.

Incidentally, it is preferable that the precharge voltage is not higher than the anode voltage Vdd minus 0.5 V and not lower than the anode voltage Vdd minus 2.5 V in FIG. 1.

Even with methods which perform precharging only for the 0th gradation, it is useful to perform precharging selecting one or two colors from among R, G, and B. This will cause less harm to image display. It is also useful to perform precharging when the screen brightness is below a predetermined brightness or above a predetermined brightness. In particular, when the brightness of the display screen 144 is low, black display is difficult. Precharge driving at low contrast such as 0-gradation precharging will improve perceived contrast of images.

It is preferable to provide several modes which can be switched by a command: including a 0th mode in which no precharging is performed, first mode in which precharging is performed only for the 0th gradation, second mode in which precharging is performed in the range of the 0th to 3rd gradations, third mode in which precharging is performed in the range of the 0th to 7th gradations, and fourth mode in which precharging is performed in the entire range of gradations. These modes can be implemented easily by constructing (designing) a logic circuit in the source driver circuit (IC) 14.

The switch 151a is turned on and off according to applied signals. When the switch 151a is turned on, the precharge voltage PV is applied to the source signal line 18. Incidentally, the duration of application of the precharge voltage PV is set by a counter (not shown) formed separately. The counter is configurable by commands. Preferably, the application duration of the precharge voltage is from 1/100 to ⅕ of one horizontal scanning period (1 H) both inclusive. For example, if 1 H is 100 μsec, the application duration should be from 1 μsec to 20 sec (from 1/100 to ⅕ 1 H) both inclusive. More preferably, it should be from 2 μsec to 10 μsec (from 2/100 to 1/10 of 1 H) both inclusive.

The output from the coincidence circuit 161 and output from the counter circuit 162 are ANDed by the AND circuit 163, and consequently a black level voltage Vp is output for a predetermined period.

FIG. 75 shows an example which allows the precharge voltage to be varied according to gradations. In FIG. 75, it can be easily realized to vary the precharge voltage depending on the image data to be applied. The precharge voltage can be varied by the electronic regulator 501 based on image data (D3 to D0) In FIG. 75, the D3 to D0 bits are connected to the electronic regulator to allow the precharge voltage for low gradations to be varied. This is because a weak current is used for black display and a large current is used for white display.

Thus, the lower the gradation region, higher the precharge voltage should be. Since the driver transistors 11a of pixels 16 are P-channel transistors, the anode voltage (Vdd) is closer to a complete black display voltage. The higher the gradation region, the lower the precharge voltage should be (if the pixel transistors 11a are P-channel transistors). That is, voltage programming is performed in low gradation regions and current programming is performed in high gradation regions (white display).

In FIG. 75, of course, the precharge voltage may be varied or controlled according to temperature, lighting ratio, reference current ratio, or duty ratio in addition to being varied according to gradations. Also, the application duration of the precharge voltage may be varied or controlled according to the temperature, lighting ratio, reference current ratio, or duty ratio.

With the precharge circuit in FIG. 75, it is possible to select whether to perform precharging for only gradation 0 or gradations 0 to 7. Also, precharge voltages for individual gradations can be varied by the electronic regulator 501.

Good results can also be obtained if the duration of application of the precharge voltage PV is varied using the image data applied to the source signal lines 18. For example, the application duration may be increased for the 0th gradation of completely black display, and made shorter for the 4th gradation. Also, good results can be obtained if the application duration is specified taking into consideration the difference between image data and image data to be applied 1 H later.

For example, when writing a current into the source signal lines to put the pixels in black display mode 1 H after writing a current into source signal lines to put the pixels in white display mode, the precharge time should be increased. This is because a weak current is used for black display. Conversely, when writing a current into the source signal lines to put the pixels in white display mode 1 H after writing a current into source signal lines to put the pixels in black display mode, the precharge time should be decreased or precharging should be stopped. This is because a large current is used for white display. Of course, the precharge time may be controlled (varied) according to the lighting ratio.

It is also useful to vary the precharge voltage depending on the image data to be applied. This is because a weak current is used for black display and a large current is used for white display. Thus, it is useful to raise the precharge voltage (compared to Vdd. When P-channel transistors are used as pixel transistor 11a) in a low gradation region and lower the precharge voltage (when P-channel transistors are used as pixel transistor 11a) in a high gradation region It is useful to add a (proper precharging) capability to stop precharging when a white display area (area with a certain brightness) (white area) and a black display area (area with brightness below a predetermined level) (black area) coexist in the screen and the ratio of the white area to the black area falls within a certain range. It is because vertical streaks appear in this range. Conversely, precharging may be done in this range because images may act as noise when they move. Proper precharging can be implemented easily by counting (calculating) pixel data which correspond to the white area and black area using an arithmetic circuit.

It is also useful to vary precharge control among R, G, and B because emission start voltage and emission brightness of EL display elements 15 vary among R, G, and B. For example, a possible method involves stopping or starting precharging for R when the ratio of a white area with a predetermined brightness to a black area with a predetermined brightness is 1 to 20 or above and stopping or starting precharging for G and B when the ratio of a white area with a predetermined brightness to a black area with a predetermined brightness is 1 to 16 or above.

It has been shown experimentally and analytically that in an organic EL display panel, preferably precharging should be stopped or started when the ratio of a white area with a predetermined brightness to a black area with a predetermined brightness is 1 to 100 or above (i.e., the black area is at least 100 times larger than the white area). More preferably, precharging should be stopped or started when the ratio of a white area with a predetermined brightness to a black area with a predetermined brightness is 1 to 200 or above (i.e., the black area is at least 200 times larger than the white area).

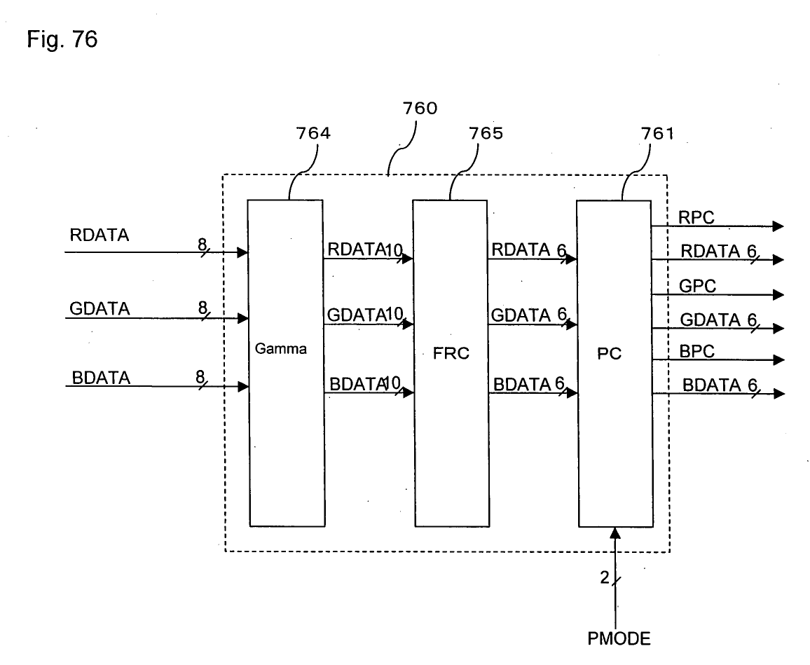

As described above and illustrated in FIG. 76, each of the R, G, and B image data (RDATA, GDATA, and BDATA) is 8-bit data. Each of the 8-bit R, G, and B image data is subjected to gamma conversion by a gamma circuit 764, and thereby converted into a 10-bit signal. The signals resulting from the gamma conversion are subjected to an FRC process by a frame rate control (FRC) circuit 765, and thereby converted into 6-bit image data. A precharge control (PC) circuit 761 generates a precharge control signal (which is set high (H) for precharging, or set low (L) for no precharging) from the 6-bit image data. A method of generating the precharge will be described later.

Preferably, the FRC uses 8-bit or 6-bit processing for the 10-bit signals to avoid image corruption.

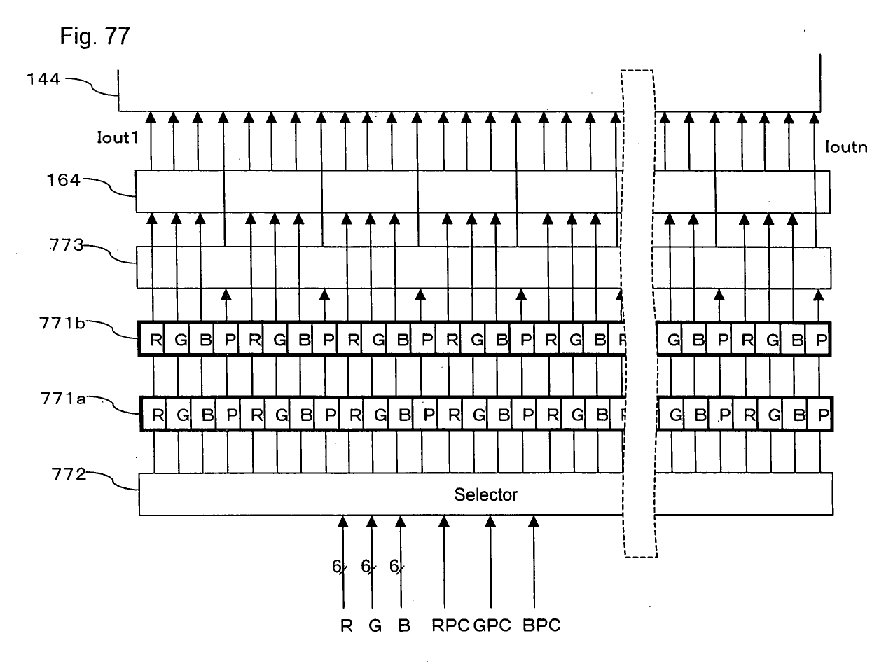

FIG. 77 is a block diagram showing mainly a precharge circuit 773 of the source driver circuit (IC) 14. The precharge circuit 773 outputs the precharge control (PC) signal (red (RPC), green (GPC), and blue (BPC)) generated by the precharge control circuit 761. The PC signal is generated by the precharge control circuit 761 of a control IC 81 illustrated in FIG. 76 and inputted in a selector circuit 772 of the source driver IC 14 illustrated in FIG. 77.

The selector circuit 772 latches data onto a latch circuit 771 in sequence in sync with a main clock, where the latch circuit 771 corresponds to output circuits. The latch circuit 771 consists of two stages: latch circuit 771a and latch circuit 771b. The latch circuit 771b sends out data to the precharge circuit 773 in sync with a horizontal scanning clock (1 H). That is, the selector latches one pixel row of image data and PC data in sequence and stores the data in the latch circuit 771b in sync with the horizontal scanning clock (1 H).

Incidentally, in the latch circuit 771 in FIG. 77, R, G, and B indicate 6-bit image data while P indicates the 3-bit precharge signal (RPC, GPC, and BPC).

When the output of the latch circuit 771b is high, the precharge circuit 773 turns on the switch 151a to output a precharge voltage to the source signal line 18. The current output circuit 164 outputs a programming current to the source signal line 18 according to image data.

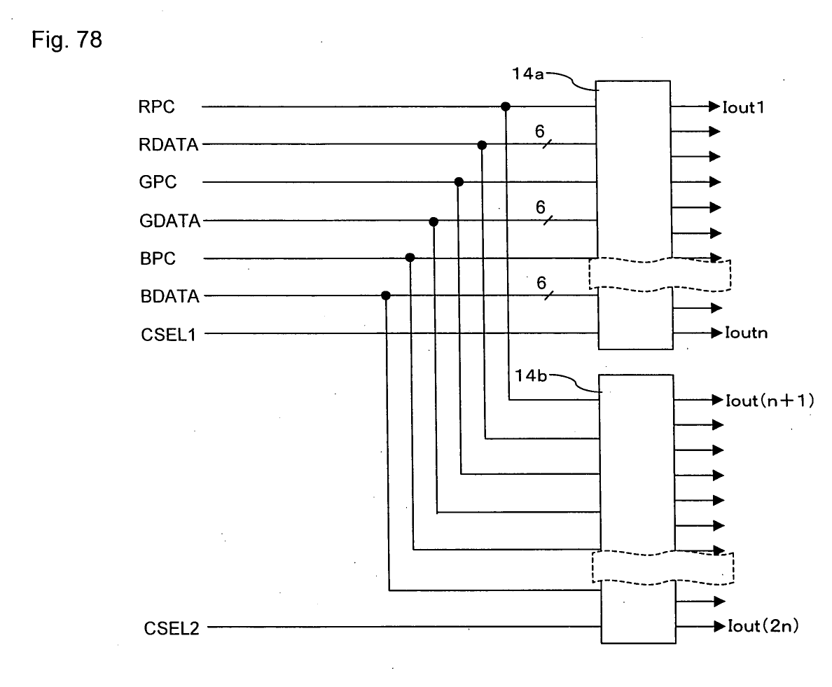

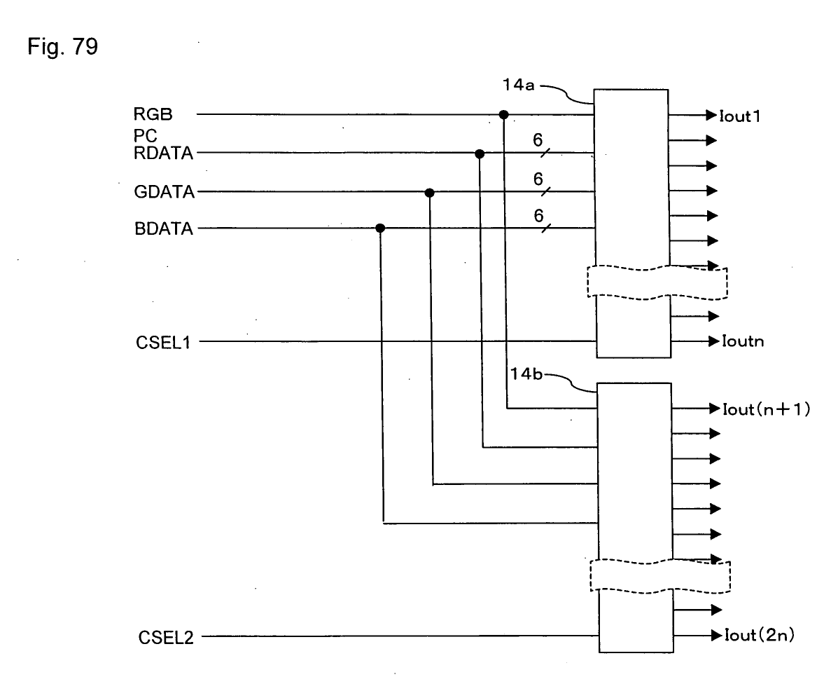

The configuration in FIGS. 76 and 77 is schematically illustrated in FIG. 78. Incidentally, FIGS. 78 and 79 show configurations in which a plurality of source driver circuits (IC) 14 (a cathode connection of source driver ICs) are mounted on a single display panel. Besides, CSEL1 and CSEL2 in FIGS. 78 and 79 denote select signals of an IC chip. The select signals CSEL determine which IC chip to select to input the image data and PC signal.

In the configuration in FIGS. 77 and 78, the precharge control (PC) signal is generated for each item of R, G, and B image data. In this way, it is preferable to apply precharge voltages separately for R, G, and B. However, in the case of movie display and natural image display, it is often unnecessary to determine separately for R, G, and B whether to perform precharging. Thus, it is possible to convert R, G, and B image data into a brightness signal and determine, according to brightness, whether to perform precharging. Such a configuration is shown in FIG. 79.

In the configuration in FIG. 78, the PC signal needs to be a 3-bit signal (RPC, GPC, and BPC) while in the configuration in FIG. 79, the PC signal only needs to be a 1-bit signal. Thus, in the latch circuit 771 in FIG. 77, P only needs to be a 1-bit latch. Incidentally, for ease of explanation and drawing, R, G, and B are not treated separately in the following description.

The above configurations according to the present invention are characterized in that the controller circuit (IC) 760 generates image data based on the PC signal (precharge control signal) and that the source driver IC 14 latches the PC signal and applies it to the source signal lines 18 in sync with a horizontal synchronization signal. Besides, the controller 81 can easily change the way the precharge signal is generated, according to a precharge mode (PMODE) signal as illustrated in FIG. 76.

Precharge modes (PMODE) include, for example, a mode in which only pixels for gradation 0 are precharged, a mode in which pixels in-a certain range of gradations such as gradations 0 to 7 are precharged, a mode in which pixels are precharged when image data changes from bright image data to dark image data, and mode in which pixels are precharged when low-gradation display continues for a certain number of frames.

Determinations as to whether to perform precharging may be made not only for image data of a single pixel, but also for image data of multiple pixel rows. Also, determinations about precharging may be made taking into consideration (e.g., weighing) the image data of those pixels which are around the pixels to be precharged. There is a method which varies the way how determinations about precharging are made between moving pictures and still pictures. An important feature here is that the controller generates the precharge signal based on image data, thereby achieving great versatility. The following description will focus on determinations about precharging as well as on precharge modes.

The determinations as to whether to precharge pixels may be based on the image data of the previous pixel row (or the image data applied to the source signal line 18 just before). Suppose, for example, the image data applied to a source signal line 18 changes in the order: white, black, and black. A precharge voltage is applied when the image data changes from white to black. This is because black gradation data is difficult to write. When changing from black to black, no precharge voltage is applied because the source signal line 18 has already been set at the potential for black display in the previous black display. The above operations can be accomplished easily by forming (placing) one pixel row of line memory (two lines of memory are required because of FIFO).

Although it is stated herein that precharge voltage is outputted in the case of precharge driving, this is not restrictive. A current larger than a programming current may be written into the source signal line 18 for a period shorter than one horizontal scanning period. That is, a precharge current may be written into the source signal line 18 before writing a programming current into the source signal line 18. The precharge current causes voltage changes all the same in a physical sense. The use of precharge current is also included within the technical scope of the present invention.

For example, the electronic regulator 501 used to vary the precharge voltage in FIG. 75 can be changed to a current-output type. This change can be achieved easily by combining a plurality of current mirror circuits. It is assumed herein for ease of explanation that precharge voltage is used for precharge driving.

The present invention is not limited to application of a fixed precharge voltage (current). A plurality of precharge voltages may be applied to source signal lines. For example, it is possible to apply a 5-volt precharge voltage for 5 μsec, a 4.5-volt precharge voltage for 5 μsec, and then a programming current Iw to the source signal line 18.

In precharge driving, the voltage applied may have a sawtooth waveform or a rectangular waveform. Also, a precharge voltage (current) may be superimposed over a regular programming current (voltage). The magnitude and application duration of the precharge voltage may be varied according to image data. The type of applied waveform, values of precharge voltage, etc. may be varied according to values of image data.

Although it is stated herein that precharge voltage is applied in current driving, precharge driving also works well for voltage driving. Voltage driving involves high gate capacity because large driver transistors are used to drive the EL elements 15. This makes it difficult to write regular programming voltage. To deal with this problem, precharging is performed before application of programming voltage, thereby resetting the driver transistors. This allows proper writing.

Thus, the precharge driving according to the present invention is not limited to driving based on current programming. However, in examples of the present invention, current-driven pixel configurations are cited for ease of explanation (see FIG. 1, etc.).

In the examples of the present invention, it is not that precharge driving works only for driver transistors 11a. For example, precharge driving also works well for the transistors 11a which compose current mirror circuits in the pixel configurations in FIGS. 11, 12, and 13. The precharge driving according to the present invention is intended to charge and discharge parasitic capacitance of source signal lines 18 as viewed from the source driver circuit (IC) 14, and naturally it is also intended to charge and discharge parasitic capacitance of the source driver circuit (IC) 14.

The precharge voltage (current) is intended to achieve proper black display, but this is not restrictive. Proper white display can be achieved if precharge voltage (current) for white display is applied. In other words, the precharge driving according to the present invention consists in applying a predetermined voltage (current) for precharging before writing programming current (voltage) to make it easier to write the programming current (voltage).

It is stated herein that precharging is used for black display, and basically the precharging is performed with respect to the source driver circuit (IC) 14 from the driver transistors 11a using sink current. If the driver transistors are N-channel transistors, current programming is performed from the source driver circuit (IC) 14 using discharge current. With some pixel configurations, it is difficult to carry out writing during white display. Thus, the precharge driving according to the present invention is intended to change the potentials of source signal lines 18 and the like to predetermined values, and the question as to whether to perform precharging in white display or black display only depends on embodiments. Thus, the present invention is not limited to this.

Regarding the timing of application of precharge voltage (current), it is preferable to write the precharge voltage (current) after the pixel row into which programming voltage (current) is written is selected. However, this is not restrictive and it is alternatively possible to precharge source signal lines 18 by applying a precharge voltage (current) with no pixel row selected and then select the pixel row into which programming voltage (current) is written.

Although it has been stated that the precharge voltage is applied to source signal lines 18, another method is also available. For example, the voltage (Vdd) applied to the anode terminal or voltage (Vss) applied to the cathode terminal may be varied (by the application of a precharge voltage). By varying the anode voltage or cathode voltage, it is possible to increase writing capacity of the driver transistors 11a, thereby producing effect of precharging. In particular, a method which varies the anode voltage (Vdd) in a pulsed manner is very effective.

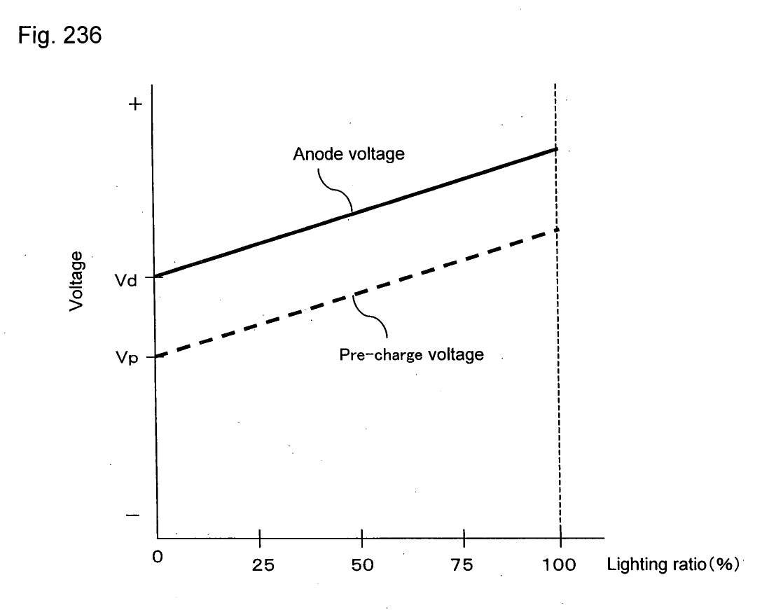

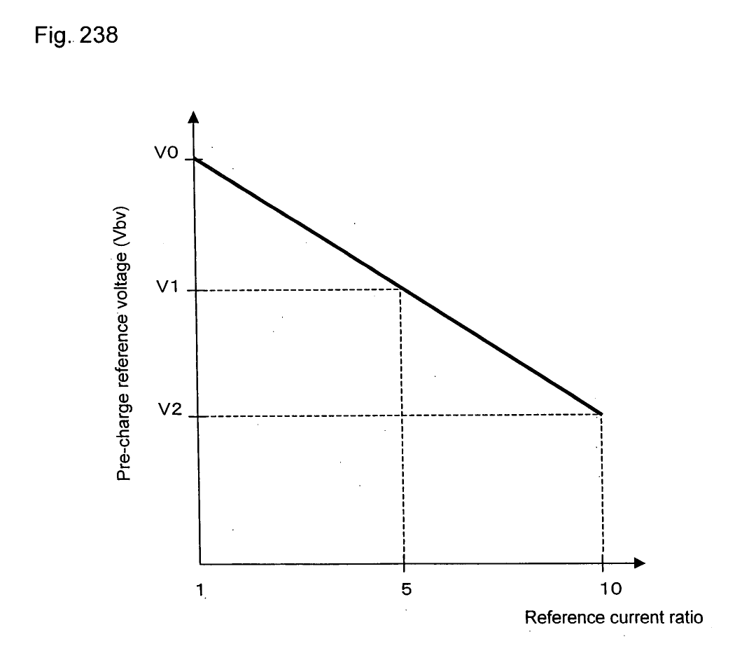

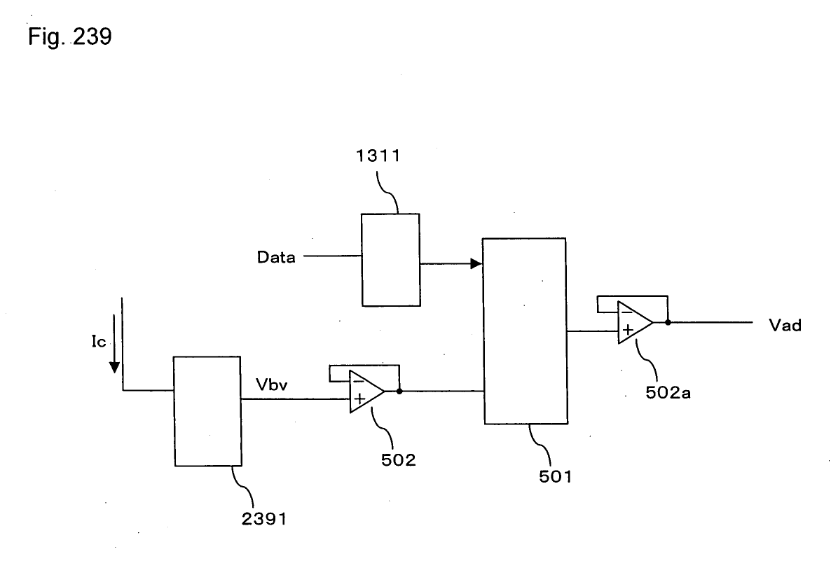

The anode voltage or precharge voltage may be varied with the lighting ratio as illustrated in FIG. 236. Also, the magnitude of precharge reference voltage (Vbv) may be varied with the reference current ratio as illustrated in FIG. 238. As illustrated in FIG. 239, the precharge reference voltage (Vbv) can be generated by an I-V conversion circuit 2391 which uses a reference current Ic (see FIGS. 127 to 143 and their explanations).

The turn-on voltage (Vgl) and turn-off voltage (Vgh) of the gate driver circuit 12 may be varied with the lighting ratio, reference current, or anode (cathode) current of the anode (cathode) terminal. In particular, it is preferable to raise Vgh along with any increase in the anode voltage Vdd.

It is stated in this example that the duty ratio, reference current ratio, etc. are varied or controlled using the lighting ratio or the anode (cathode) current of the anode (cathode) terminal, and the lighting ratio and the current of the anode terminal are proportional to the programming current Iw in current driving. Thus, it is apparent that the technical scope of the present invention also includes controlling the reference current ratio and the like by the programming current Iw, sum total of programming currents, or total of programming currents over a predetermined period (including the precharge control and the like described earlier or later as well as, for example, the timing to switch between voltage programming and current programming in FIG. 127 and the like).

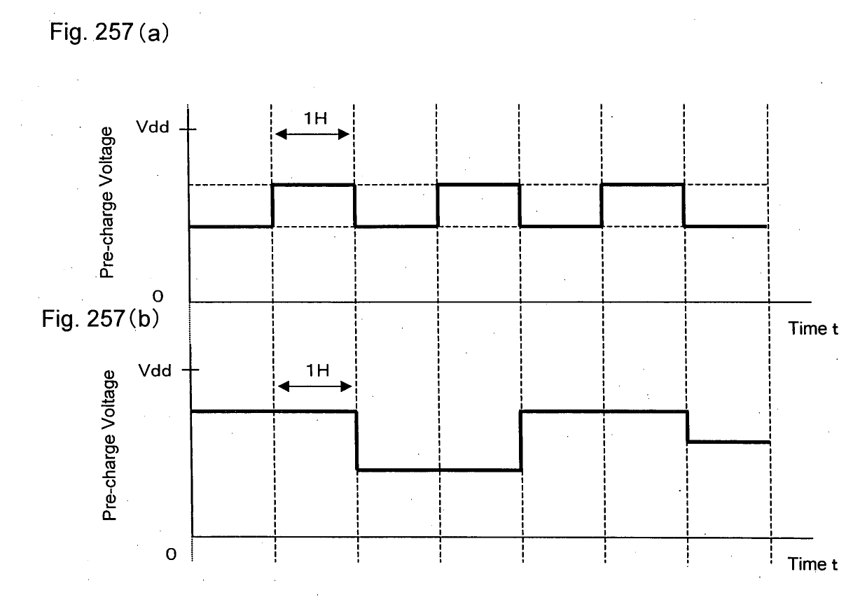

In FIG. 75 and the like, it is also useful to vary precharge voltage (or precharge current) every horizontal scanning period (1 H) (illustrated in FIG. 257(a)). Also, as illustrated in FIG. 257(b), the precharge voltage (or precharge current) may be varied over a plurality of horizontal scanning periods. Alternatively, precharge voltage may be applied at random in such a way that the average effective voltage will equal a target precharge voltage. It is alternatively possible to operates on (e.g., adds) the image data of the pixel row to which the precharge voltage is applied and apply a precharge voltage (current) especially if low-gradation image (video) data makes up a large proportion. In this case, the precharge voltage (current) is varied according to the results of the arithmetic operations. This is because with relatively high gradations, halation occurs in the EL panel, causing certain low-gradation pixels to appear brighter. Thus, by applying a precharge voltage to pixels 16 lower in gradation than the certain low-gradation pixels, it is possible to achieve more complete black display, increasing the perceived contrast of the image.

A fixed voltage may be applied to the certain low-gradation pixels (poor black reproduction occurs with the certain low-gradation pixels) or the precharge voltage may be varied according to the image data applied to pixels by controlling the value of precharge voltage modification data D in FIG. 75.

This capability to vary the precharge voltage (current) on a case-by-case basis owes greatly to the fact that the source driver circuit (IC) 14 incorporates an electronic regulator 501 as illustrated in FIG. 75. That is, the precharge voltage and the like can be varied digitally from outside the source driver circuit (IC) 14. The digital data D used for this is generated by the controller IC (circuit) 760. Thus, the functions of the source driver circuit (IC) 14 and controller IC (circuit) 76 are separated, making design or changes easier.

Although it has been stated that the precharge voltage and the like are varied within a 1H period, the present invention is not limited to this. It is also possible to operate on image (video) data for multiple pixel rows (e.g., ten pixel rows), specify modification data D, and apply a precharge voltage (current) (see FIG. 257(b)). Also, it is alternatively possible to operate on image (video) data in a single frame (field) or multiple frames (fields) and apply a precharge voltage (current).

Incidentally, although it has been stated that the precharge voltage (current) is varied or set to a predetermined voltage by operating on image (video) data and applied to pixels 16 or pixel rows, this is not restrictive. Needless to say, for example, a precharge voltage (current) to be applied may be fixed in advance, or a plurality of precharge voltages or the like may be selected in advance so that they can be applied in sequence or at random to pixels, pixel rows, or the entire screen. Also, it goes without saying that no precharge voltage or the like may be applied depending on results of arithmetic operations.

Also, precharge voltages (currents) may be applied using frame rate control (FRC) technology. That is, by applying or not applying precharge voltages or the like to pixels or pixel rows for multiple frames (fields), it is possible to achieve gradation display for multiple frames (in this case, the application of precharge voltages enables gradation display). By performing FRC as described above, it is possible to achieve proper black display or gradation display using a small number of precharge voltages (currents).

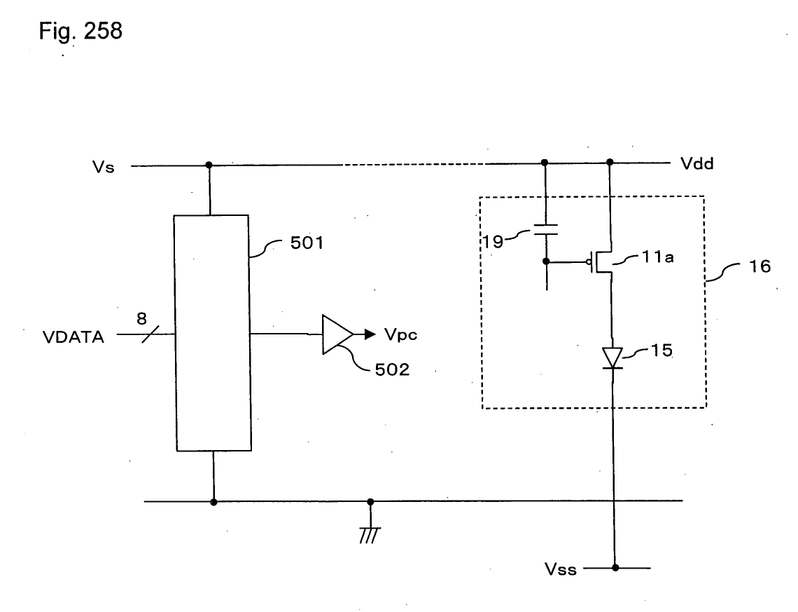

As illustrated in FIG. 258, etc., the precharge voltage Vpc is generated via the operational amplifier 502 by applying the output of the electronic regulator 501 to the operational amplifier 502. Preferably, the power supply voltage (reference voltage) Vs of the electronic regulator 501 and source terminal voltage (anode voltage) Vdd of the driver transistor 11a are shared. That is, the precharge voltage Vpc is based on the anode voltage of the driver transistor 11a.

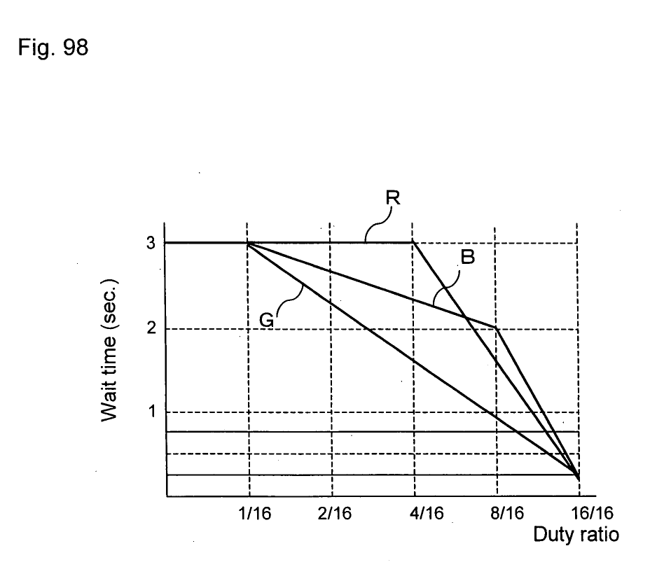

It has been stated in the above example that the precharge voltage or the like is operated on and applied to pixels 16 or the like. The precharge voltages may be applied after some delay rather than immediately after the arithmetic operations. Also, when varying the precharge voltage or the like in sequence or at random, preferably it is varied gradually, slowly, or with some hysteresis. Abrupt changes in the precharge voltage may cause streaks in images or flicker in image display. The technical idea of delays and the like has been described with reference to FIG. 98 and in other examples and can be applied here directly or similarly, and thus description thereof will be omitted.

Needless to say, details of FRC may be modified according to the lighting ratio, including whether to use FRC, for what gradations FRC should be used, and whether to control the number of converted bits in FRC.

For example, when the lighting ratio is high, the display becomes close to white raster. Thus, the entire screen is whitish and FRC is often unnecessary. On the other hand, when the lighting ratio is low, black display prevails on the screen.

In that case, it is necessary to increase gradation reproducibility by means of FRC. Although it has been stated that details of FRC are modified according to the lighting ratio, the present invention is not limited to this. For example, if the reference current is increased, the entire screen becomes whitish, often making FRC unnecessary. On the other hand, if the reference current is low, black display prevails on the screen, making it necessary to increase gradation reproducibility. The above items also apply to duty ratio control. Also, it goes without saying that details of FTC may be modified in response to changes in the anode (cathode) current.

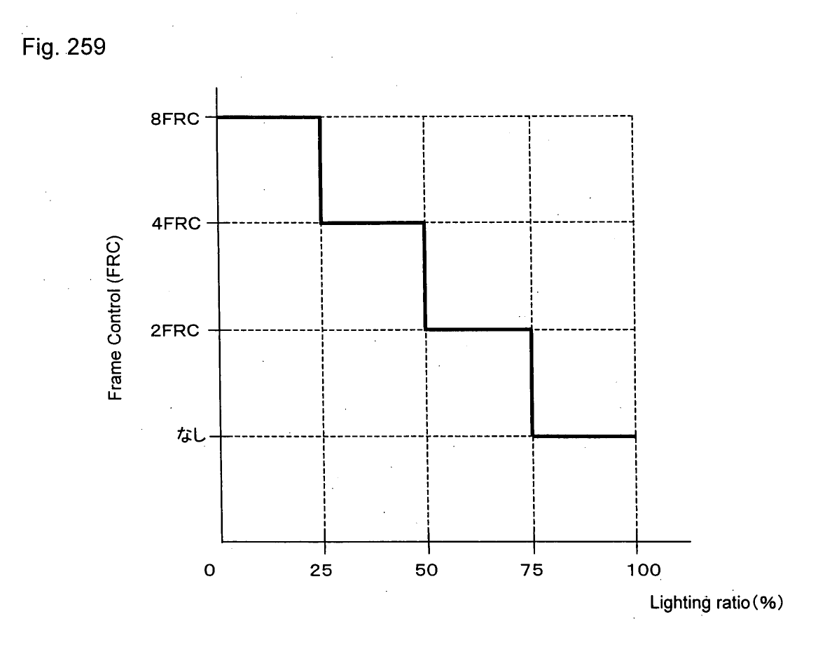

It is also useful to modify details of FRC according to the lighting ratio in the manner illustrated in FIG. 259, where 8FRC (FRC under which eight frames or fields are used for gradation display) is performed when the lighting ratio is 0 to 25%. This increases the number of displayed gradations. 4FRC (FRC under which four frames or fields are used for gradation display) is performed when the lighting ratio is 25 to 50%. Similarly, 2FRC (FRC under which two frames or fields are used for gradation display) is performed when the lighting ratio is 50 to 75%, however FRC is not performed when the lighting ratio is 75 to 100%. That is, optimum FRC is performed according to the lighting ratio. Generally, when the lighting ratio is low, since images tend to be dark, it is necessary to improve gradation representation by reducing the gamma factor and increasing the number of frames in FRC.

It is stated herein that the duty ratio and the like are varied according to the lighting ratio. However, the term lighting ratio is used in a broad sense. For example, a low lighting ratio means not only that the current flowing through the screen 144 is small, but also that images are constituted largely of low-gradation pixels, i.e., the pictures on the screen 144 consists largely of dark pixels (low-gradation pixels).

Thus, a low lighting ratio translates into a state in which video data composing the screen consists mainly of low-gradation video data when subjected to histogram processing. A high lighting ratio means not only that the current flowing through the screen 144 is large, but also that images are constituted largely of high-gradation pixels. That is, the pictures on the screen 144 consist largely of blight pixels (high-gradation pixels). Thus, a high lighting ratio translates into a state in which video data composing the screen consists mainly of high-gradation video data when subjected to histogram processing. That is, the control according to the lighting ratio may be synonymous or roughly synonymous with control according to gradation distribution or histogram distribution of pixels.

Thus, the control based on the lighting ratio can translate into case-by-case control based on the gradation distribution of pixels (low lighting ratio=large number of low-gradation pixels; high lighting ratio=large number of high-gradation pixels). For example, increasing the reference current ratio with decreases in the lighting ratio while decreasing the duty ratio with increases in the lighting ratio can be said as increasing the reference current ratio with increases in the number of low-gradation pixels while decreasing the duty ratio with increases in the number of high-gradation pixels. Increasing the reference current ratio with decreases in the lighting ratio while decreasing the duty ratio with increases in the lighting ratio is equal or similar, in meaning, operation, or control, to increasing the reference current ratio with increases in the number of low-gradation pixels while decreasing the duty ratio with increases in the number of high-gradation pixels.

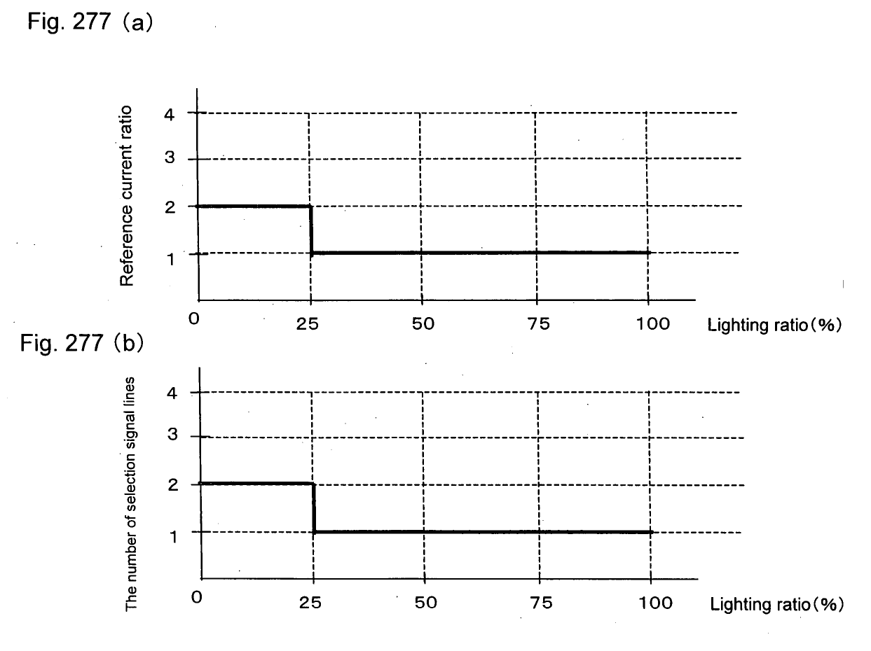

Also, for example, increasing the reference current ratio N-fold and setting the number of select signal lines to N when the lighting ratio is not higher than a predetermined value (see FIGS. 277 to 279, etc.) is equal or similar, in meaning, operation, or control, to increasing the reference current ratio N-fold and setting the number of select signal lines to N when the number of low-gradation pixels is not smaller than a certain number.

Also, for example, driving usually at a duty ratio of 1/1 and lowering the duty ratio stepwise or smoothly when the lighting ratio is not lower than a predetermined value is equal or similar, in meaning, operation, or control, to driving at a duty ratio of 1/1 when the number of low-gradation or high-gradation pixels is within a certain range and lowering the duty ratio stepwise or smoothly when the number of high-gradation pixels is not smaller than a certain number.

The drive method illustrated in FIG. 442 is also included within the scope of the present invention. In FIG. 442, the horizontal axis represents the ratio of pixels not higher than the b-th gradation (e.g., b=16 in FIG. 442). If the ratio of pixels not higher than the 16-th gradation is 25%, for example, in a display panel which contains 100,000 pixels and displays 256 gradations, 25,000 pixels are not higher than the 16-th gradation. Thus, the horizontal axis in effect represents lighting ratio or similar value or index.

In the example in FIG. 442, when the ratio of pixels not lower than the 16-th gradation is 75% or above, the lighting ratio is increased and the duty ratio is reduced to keep brightness constant. When the ratio of pixels not higher than the 16-th gradation is 25% or below, the duty ratio is decreased to reduce power consumption.

Thus, the phase “based on the lighting ratio” can be paraphrased as “based on the proportion of the pixels below or above a predetermined gradation.” Needless to say, the above items similarly apply to other examples of the present invention.

Needless to say, the matters concerning the lighting ratio and the pixels below or above the 16-th gradation also apply to other types of control (e.g., precharge voltage, FRC, temperature, etc.). Also, it goes without saying that they can be combined with or applied to other examples of the present invention.

Although it has been stated in the above example that the precharge voltage, details of FRC, etc. are varied/modified or controlled according to image (video) data, the present invention is not limited to this. For example, the magnitude of precharge voltage (current) may be varied according to lighting ratio, current flowing through the anode (cathode) terminal, reference current, duty ratio, panel temperature, or combination thereof. Also, the application time of precharge voltage may be varied.

For example, since the magnitude of programming current varies with the magnitude of reference current while varying the current flowing through the driver transistor 11a, it is preferable to vary the magnitude of precharge voltage as well. When the lighting ratio is high, the screen presents a state close to white display with halation in the entire screen, resulting in insufficient black levels. Thus, the application of precharge voltage or the like to pixels 16 produces no effect. In this case, the application of precharge voltage or the like should be stopped to reduce power consumption. On the other hand, when the lighting ratio is low, black display prevails on the screen and there is not much halation, and thus it is necessary to precharge the pixels 16 sufficiently to improve perceived contrast.

Similarly, when the anode (cathode) voltage is large, white display prevails on the screen, and thus the screen is prone to halation. In this case, it is often unnecessary to apply a precharge voltage or the like. Conversely, when the anode (cathode) voltage is small, it is often necessary to apply a precharge voltage or the like.

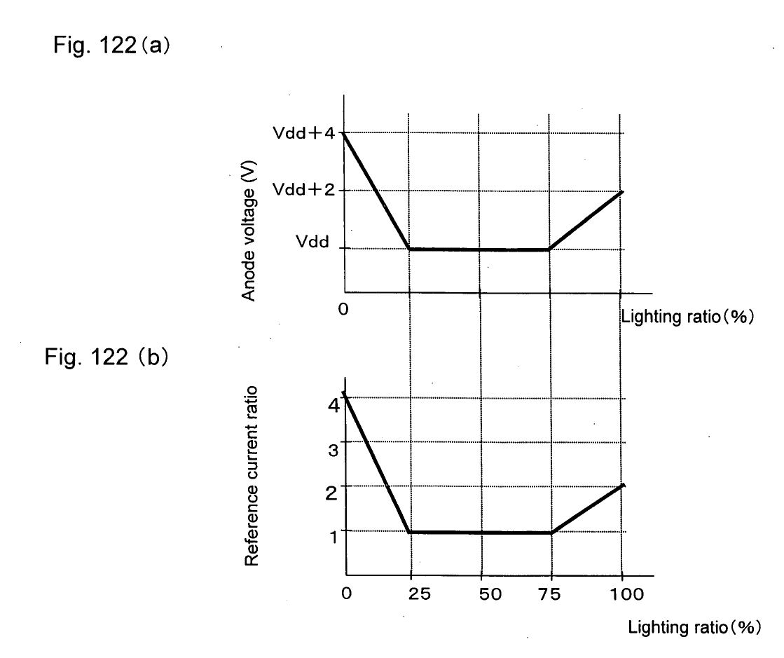

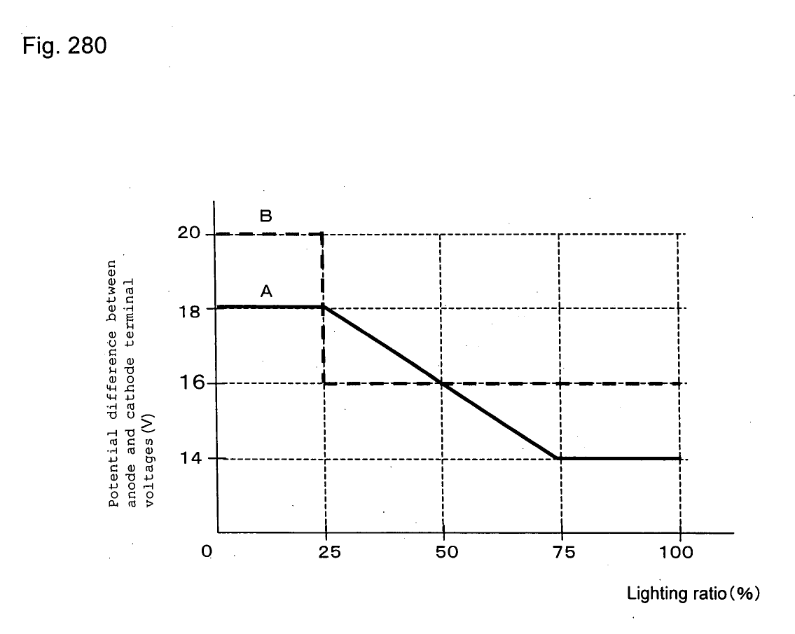

Although it has been stated in the above example that details of FRC or the magnitude of precharge voltage (current) is modified/varied according to image (video) data, lighting ratio, current flowing through the anode (cathode) terminal, reference current, duty ratio, panel temperature, or combination thereof, this is not restrictive. Needless to say, details of FRC or the magnitude of precharge voltage (current) may be modified/varied by predicting changes or the rate of change of the image (video) data, lighting ratio, current flowing through the anode (cathode) terminal, anode (cathode) terminal voltage (FIG. 122, etc.), potential difference between anode and cathode terminal voltages (FIG. 280, etc.), duty ratio, panel temperature, etc.

In this way, the present invention provides a drive method of controlling the magnitude of precharge voltage (current), whether to apply precharge voltage, the use of FRC for the application of the precharge voltage, changes in the precharge voltage, the application duration of the precharge voltage, etc. according to pixel (video) data, etc. or according to details of FRC, lighting ratio, current flowing through the anode (cathode) terminal, reference current, duty ratio, panel temperature, or combination thereof. Preferably, the variations or changes are made slowly or with some delay as described with reference to FIG. 98.

As described above, the present invention varies details of the first FRC, lighting ratio, the current flowing through the anode (cathode) terminal, reference current, duty ratio, panel temperature, or a combination thereof for the first lighting ratio (or the anode current of the anode terminal) or a range of lighting ratios (or a range of anode currents of the anode terminal).

Further, the present invention varies details of the second FRC, lighting ratio, the current flowing through the anode (cathode) terminal, reference current, duty ratio, panel temperature, or a combination thereof for the second lighting ratio (or the anode current of the anode terminal) or a range of lighting ratios (or a range of anode currents of the anode terminal). The present invention varies details of FRC, lighting ratio, the current flowing through the anode (cathode) terminal, reference current, duty ratio, panel temperature, or a combination thereof according to (to adapt to) the lighting ratio (or the anode current of the anode terminal) or a range of lighting ratios (or a range of anode currents of the anode terminal) Needless to say, the above items also apply to other examples of the present invention.

As described above, the present invention varies details of the first FRC, lighting ratio, the current flowing through the anode (cathode) terminal, reference current, duty ratio, panel temperature, or a combination thereof for the first lighting ratio (or the anode current of the anode terminal) or a range of lighting ratios (or a range of anode currents of the anode terminal).

Although it is described that the present invention varies details of the second FRC, lighting ratio, the current flowing through the anode (cathode) terminal, reference current, duty ratio, panel temperature, or a combination thereof for the second lighting ratio (or the anode current of the anode terminal) or a range of lighting ratios (or a range of anode currents of the anode. terminal), the present invention is not limited to this. For example, either or both of the turn-on voltage and turn-off voltage of the gate driver circuits 12 may be varied according to the lighting ratio.

The lighting ratio in the above description represents a display mode of an image. A low lighting ratio represents an image in which black display prevails (an image containing a large number of low-gradation pixels) while a high lighting ratio represents an image in which white display prevails (an image containing a large number of high-gradation pixels). The lighting ratio also represents the magnitude of current flowing into the anode terminal (current flowing out of the cathode terminal). When the lighting ratio is low, since black display prevails in the image, the current flowing into the anode terminal (current flowing out of the cathode terminal) is small. When the lighting ratio is high, since white display prevails in the image, the current flowing into the anode terminal (current flowing out of the cathode terminal) is large. The present invention varies the duty ratio, the panel temperature, details of FRC, the reference current, etc. using the above items.

A low lighting ratio represents an image in which black display prevails (an image containing a large number of low-gradation pixels). In an image in which black display prevails, leakage of transistors 11 can cause bright spots and insufficient black levels. To deal with this problem, it is useful to manipulate the turn-on and turn-off voltages of the gate driver circuits 12. An example is shown below.

The EL element 15 is a self-luminous element. When light from this self-luminous element enters a transistor serving as a switching element, a photoconductive phenomenon occurs. The photoconductive phenomenon is a phenomenon in which leakage (off-leakage) increases due to photoexcitation when a switching element such as a transistor is off.

To deal with this problem, the present invention forms a shading film under the gate driver circuit 12 (source driver circuit (IC) 14 in some cases) and under the pixel transistor 11. In particular, it is preferable to shade the transistor 11b placed between a potential position (denoted by c) of the gate terminal and potential position (denoted by a) of the drain terminal of the transistor 11a. This configuration is shown in FIGS. 314(a) and 314(b). When the display panel is displaying black, in particular, the potential at the potential position b of the anode terminal of the EL element 15 in FIGS. 314(a) and 314(b) is close to cathode potential. Thus, when a TFT 17b is on, the potential a is low. Thus, the potential between the source terminal and drain terminal (potentials c and a) increases, making the transistor 11b prone to leakage.

To solve this problem, it is useful to form a light-shielding film 3141 as illustrated in FIGS. 314(a) and 314(b). The shading film 3141 is formed of thin film of metal such as chromium and is from 50 nm to 150 nm thick (both inclusive). When film thickness 3141 is thin, a poor shading effect will be provided, while a thick film will cause irregularities, making it difficult to pattern the transistor 11 in an upper layer.

Since increase in the potential between the source terminal and drain terminal (potentials c and a) makes the transistor 11b prone to leakage, the leakage can be reduced if the voltage between potentials c and a is lowered. For that, it is useful to raise the turn-on voltage (Vgl2) of the transistor 11d. Incidentally, Vgl2 is a turn-on voltage of the gate driver circuit 12b.

If there is marked leakage in black display, the turn-on voltage Vgl2 can be raised at a low lighting ratio.

If the turn-on voltage Vgl2 is increased, the transistor lid will not turn on completely because of increased on-resistance of the transistor 11d. Consequently, the voltage at point a does not fall. This eliminates leakage of the transistor 11b. On the other hand, when the lighting ratio is high, the terminal voltage of the EL element 15 rises. Thus, it is necessary to lower the on-resistance of the transistor 11d.

An example is shown in FIG. 315. As indicated by a dotted line in FIG. 315, when the lighting ratio is high, the turn-on voltage Vgl2 is lowered (in the negative direction) and as the lighting ratio lowers, the turn-on voltage Vgl2 is raised to increase the on-resistance of the transistor 11d. Needless to say, the lighting ratio can translate into the magnitude of the current at the anode (cathode) terminal. Also, it goes without saying that the lighting ratio may be controlled not only as indicated by the dotted line in FIG. 315, but also as indicated by a solid line.

It has been stated with reference to FIG. 315 that the voltage Vgl2 is varied according to the lighting ratio. As a means of reducing leakage current of the transistor 11b, the cathode voltage Vss may be varied as illustrated in FIG. 307. If there is marked leakage in black display, the cathode voltage Vss can be raised at a low lighting ratio. If the cathode voltage Vss is increased, the transistor 11d will not turn on completely because of increased on-resistance of the transistor 11d. This eliminates leakage of the transistor 11b. On the other hand, when the lighting ratio is high, the terminal voltage of the EL element 15 rises. Thus, it is necessary to lower the on-resistance of the transistor 11d in order to lower the on-resistance. Thus, the cathode Vss voltage is lowered. Needless to say, the lighting ratio can translate into the magnitude of the current at the anode (cathode) terminal. Also, it goes without saying that the lighting ratio may be controlled not only as indicated by the dotted line in FIG. 315, but also as indicated by a solid line.

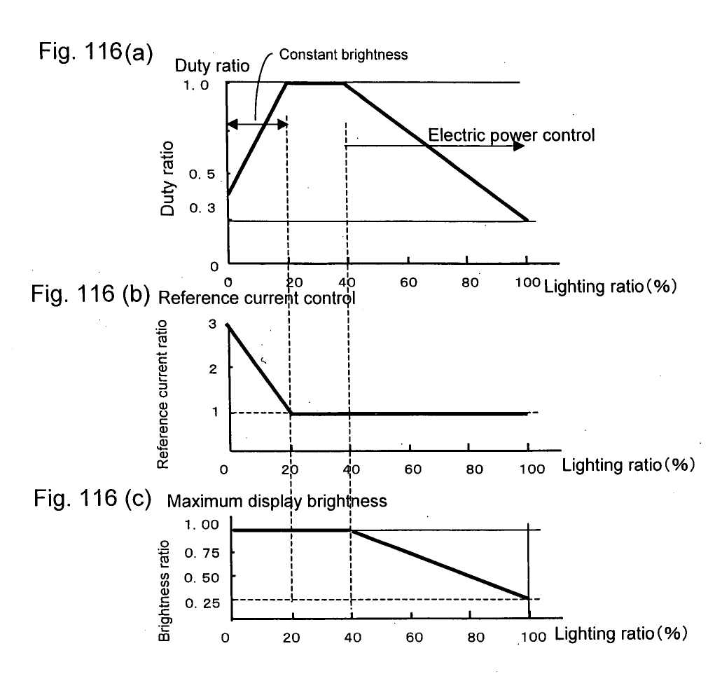

Preferably, Vgl2 is also varied in duty ratio control. The duty ratio is often changed together with reference current. For example, in FIG. 116, when the lighting ratio is 20% or below, the duty ratio is reduced (the proportion of non-illuminated area 192 in the screen 144 is increased) while increasing the reference current ratio (increasing the programming current Iw per gradation). By controlling the duty ratio (FIG. 116(a)) together with the reference current (FIG. 116(b)) (duty ratio×reference current=constant), it is possible to solve the problem of cross talk or insufficient black levels in current programming without varying display brightness (FIG. 116(c)).

With the drive method in FIG. 116, since the duty ratio multiplied by the reference current is constant, the current flowing through the anode terminal is increased with decreases in the duty ratio. In fixed control in which anode and cathode voltages are constant, the on-resistance of the transistor 11d must be decreased by lowering Vgl2.

Thus, it is preferable to vary Vgl2 in response to changes in the duty ratio as illustrated in FIG. 318. In FIG. 318, when the duty ratio is between 1/1 and ½, Vgl2=0 V. Consequently, the on-resistance of the transistor 11d is relatively high and the transistor 11b is less prone to leakage. This eases the problem of insufficient black levels. When the duty ratio is 1/1 or smaller, Vgl2=−8 V. This makes it possible to reduce the on-resistance of the transistor 11d, pass a sufficient programming current through the transistor 11a, and illuminate the EL element 15 properly in a saturation region. When the duty ratio is between ¼ and ½, Vgl2 is varied within a range of −8 to 0 V according to the duty ratio or reference current ratio.

Needless to say, the above items can be applied similarly to and combined with other examples of the present invention.

Although it has been stated with reference to FIG. 78 and the like that R, G, and B pixel data and precharge data (PRC, PGC, and PBC) are applied to the source driver circuit (IC) 14 in parallel., the present invention is not limited to this. The configuration in which the data are applied in parallel increases the number of wires connecting the controller 81 with the source driver IC 14. This presents a problem of increased pin count on the controller 81, increasing the controller size.

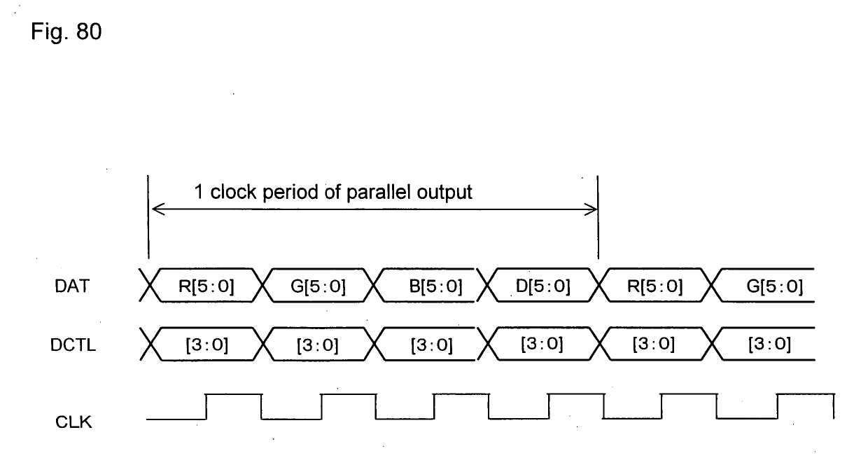

To solve this problem, according to the present invention, 10-bit data consisting of 6-bit image data (DAT) and 4-bit control data (DCTL) (including precharge data) are applied to the source driver circuit (IC) 14 from the controller 81 as illustrated in FIG. 80.

Specifically, images are transferred serially using a clock four times longer than a clock used conventionally (in a parallel transfer of R, G, and B data). That is, as illustrated in FIG. 80 (see DAT), 6-bit R data, 6-bit G data, 6-bit B data, and 6-bit control data are transferred in a conventional one clock period. The image data and control data are treated as setting data.

R, G, B data identification data (D) is identified by 4-bit DCTL. By transferring the image data and control data serially (four phases), it is possible to reduce the number of wires connecting the controller with the source driver circuit (IC) 14, and thereby reduce the size of the control IC.

FIG. 80 shows a method of applying 10-bit data consisting of 6-bit image data (DAT) and 4-bit control data (DCTL) (including precharge data) to the source driver IC 14 from the controller 81. Also, serial image transfer is performed using a four-fold clock. However, the present invention is not limited to this. For example, the R, G, and B image data and control data D may be transmitted serially and the image data and control data may be identified by an ID signal. The ID data indicates the image data when it is high and indicates the control data when it is low.

It is alternatively possible to transfer the R, G, and B image data serially and determine whether to precharge the image data based on a precharge identification signal PRC. When the PRC signal is high, the image data is applied to the source signal line 18 after precharging and when the PRC signal is low the image data is applied without precharging.

Needless to say, the image data and control data may be transmitted separately in a serial fashion as illustrated in the figure. Of course the image data may be transmitted serially and control data may be transmitted in parallel.

In the above example, the input data in the source driver circuit (IC) 14 is transmitted serially. However, the present invention is not limited to this. For example, the data may be transmitted as differential signals. Means of generating differential signals includes, for example, LVDS, CMADS, RSDS, mini-LVDS, and self-transfer methods.

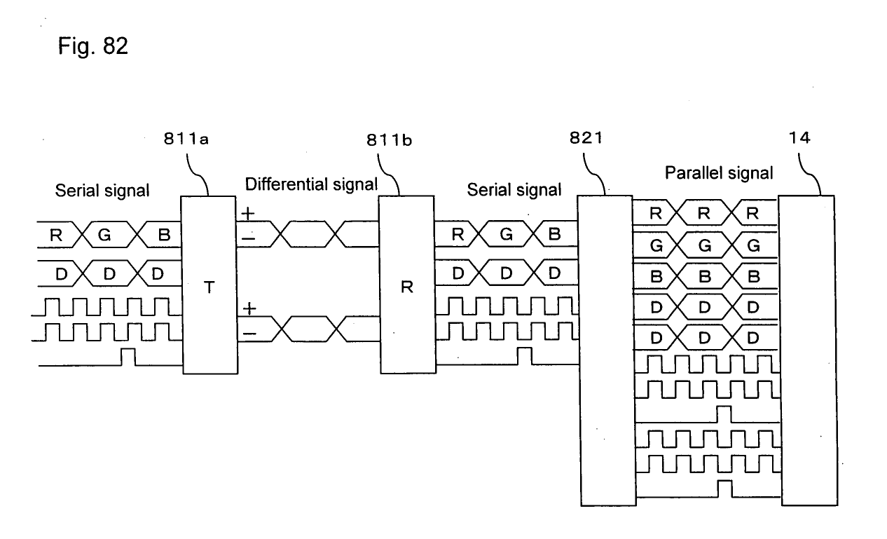

FIG. 82 shows an example in which serial video data and the like are converted into differential signals of higher frequency for transmission, and after transmission, the differential signals are reconverted into serial video data and the like, which are then inputted in the source driver circuit (IC) 14 or further converted into parallel data before being inputted in the source driver circuit (IC) 14. That is, the video data is transmitted after being converted into serial data and differential signals. Needless to say, the data may be transmitted in parallel on all or part of the route, or part of the data may be transmitted in parallel.

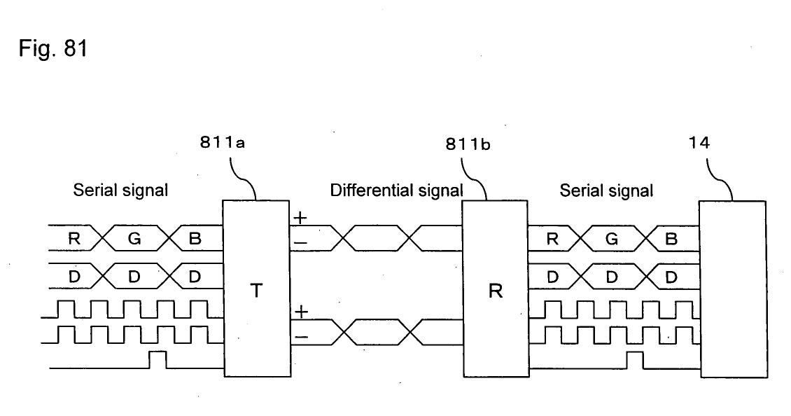

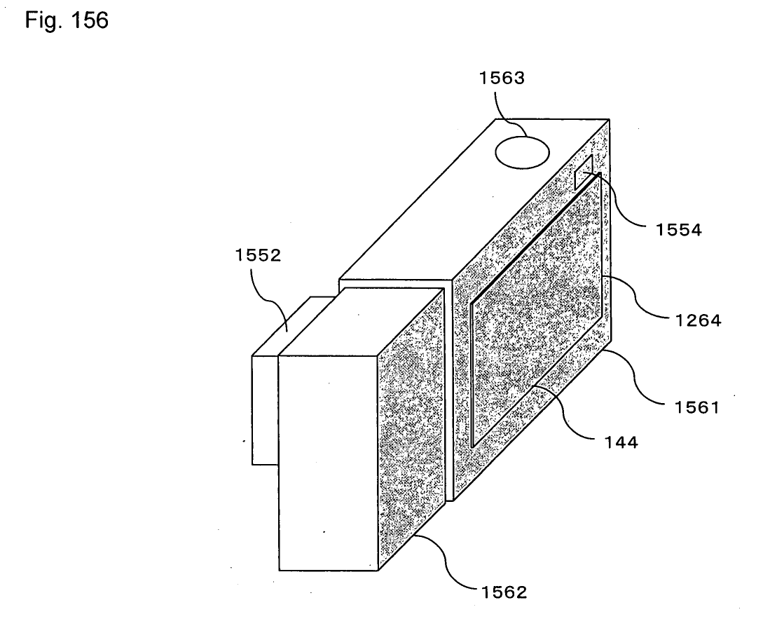

As illustrated in FIG. 81, serial data from a video processing circuit of the main body (e.g., 1561 in FIG. 156) is converted into differential signals by a transceiver (transmitter) (T) 811a serving as a differential circuit. The conversion into differential signals reduces the amplitudes of the signals, makes the signals less subject to noise, and decreases spurious radiation. This makes it possible to increase the distance between transmitter (T) 811a and receiver (R) 811b and reduce the number of signal lines.

The differential signals are converted into serial data by the receiver (R) 811b serving as a differential circuit. Of course, the differential signals may be converted into parallel data at once by incorporating functions of the controller IC 821 shown in FIG. 82 into the receiver (R) 811b. The receiver (R) 811b restores the serial data which existed before conversion by the transmitter (T) 811a.

FIG. 82 shows a configuration example in which a serial-parallel conversion circuit 821 is installed in a stage next to the receiver (R) 811b. The serial-parallel conversion circuit 821 is a controller IC (circuit) (control means) consisting, specifically, of an ASIC. The serial data is converted into parallel data by the serial-parallel conversion circuit 821 and the resulting parallel data is inputted in the source driver circuit (IC) 14.

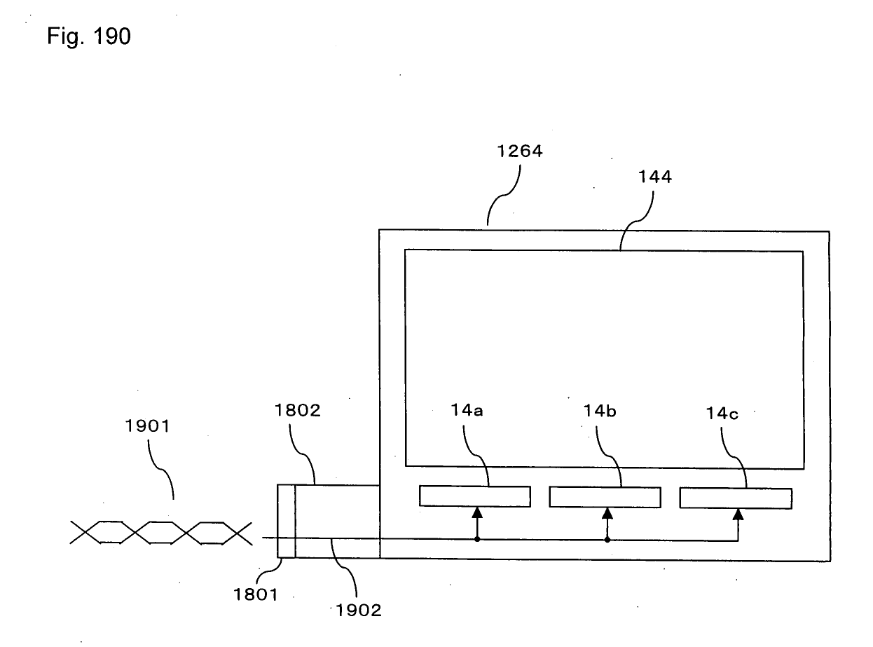

Needless to say, as illustrated in FIG. 190, a differential circuit and decoder circuit may be formed (placed) in the source driver IC 16 so that a differential signal 1901 can be inputted directly into the source driver IC 16 from out of a panel module 1264 via a connector 1801.

Regarding the control data, a variety of control data are available including, for example, the precharge data in FIGS. 16, 75, etc. and electronic regulator data in FIGS. 60, 64, 65, etc.

As illustrated in FIG. 319, in addition to the video data (RGB), an OSD (on-screen display) signal and S/D signal (still/dynamic discrimination signal) may be applied to the source driver circuit (IC) 14 as differential signals by the controller circuit (IC) 760. The OSD signal is used to display a menu screen on video cameras and the like.

When the S/D signal is high, it is determined that the transmitted RGB video signals represent a dynamic picture and a drive method is used to handle dynamic pictures as indicated by (a1), (a2), (a3), and (a4) in FIG. 54. When the S/D signal is low, it is determined that the transmitted RGB video signals represent a still picture and a split-mode drive method is used to handle still pictures as indicated by (c1), (c2), (c3), and (c4) in FIG. 54 or (b1), (b2), (b3), and (b4) in FIG. 54.

An example in which the speaker 2512 is placed or formed on the display apparatus (display panel) according to the present invention has been described with reference to FIG. 251. An audio signal (AD) for the speaker 2512 may also be applied to the source driver circuit (IC) 14 as differential signals by the controller circuit (IC) 760 as illustrated in FIG. 320.

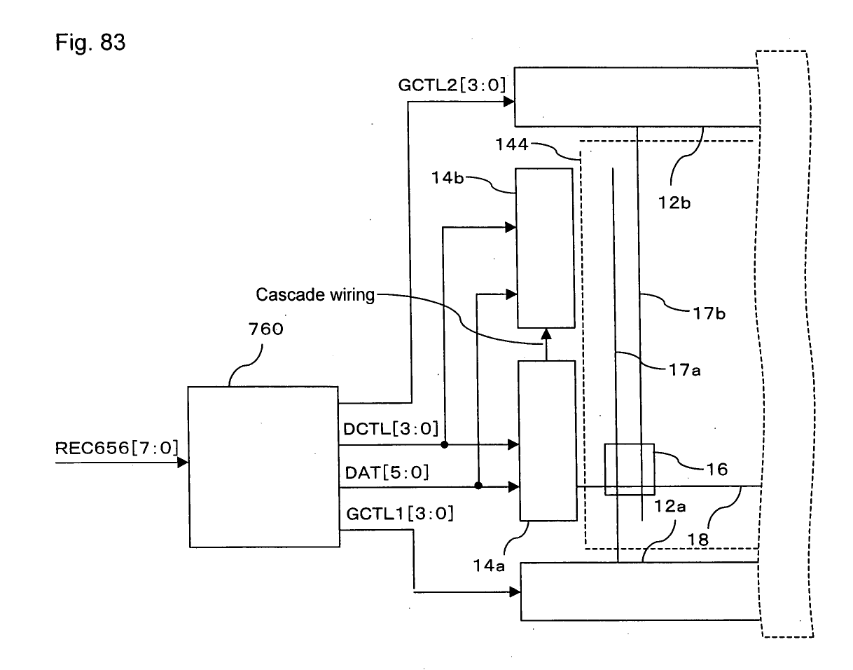

FIG. 83 shows a connection configuration of the control IC 81, source driver circuits (IC) 14, and gate driver circuits 12. By transmitting image data, electronic regulator data, and precharge data serially as DCTL and DAT, it is possible to omit connecting wires.

If serial-parallel conversion is carried out in the input stage of the source driver circuit (IC) 14, the same latch or holding circuits are used for precharge data and image data as those in FIG. 77. The four bits of GCTL constitute a clock, start pulse, up/down switch, and enable signal.

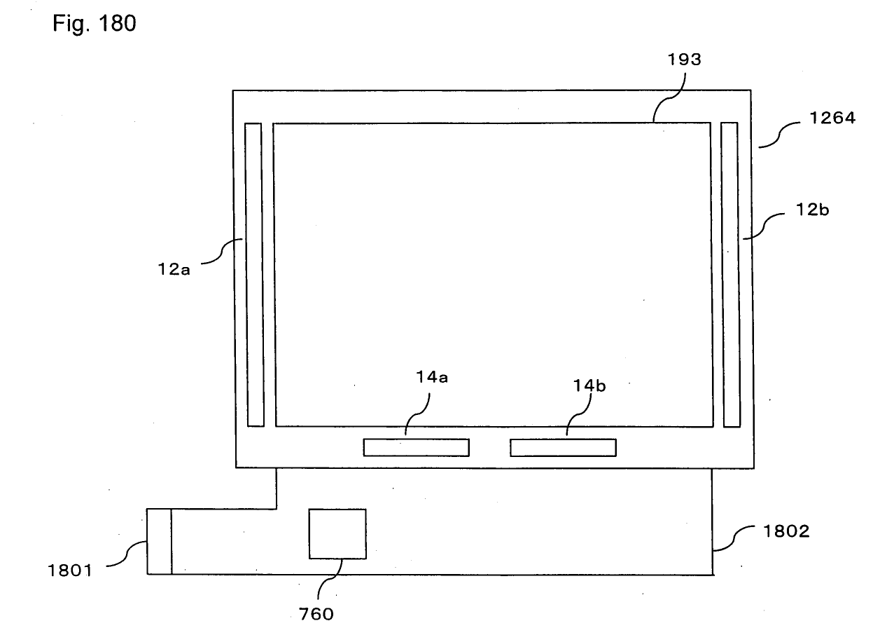

FIG. 180 is an external view of the display panel according to the present invention. The panel 1264 has the source driver ICs 14 mounted by COG technology. The gate driver circuits 12 are made of polysilicon. The flexible board 1802 is connected to terminals of the panel 1264. The controller circuit (IC) 760 is mounted on the flexible board 1802. Signals for the controller circuit (IC) 760 are inputted via a terminal 1801 and signals for the gate driver circuits 12 are also inputted via the terminal 1801.

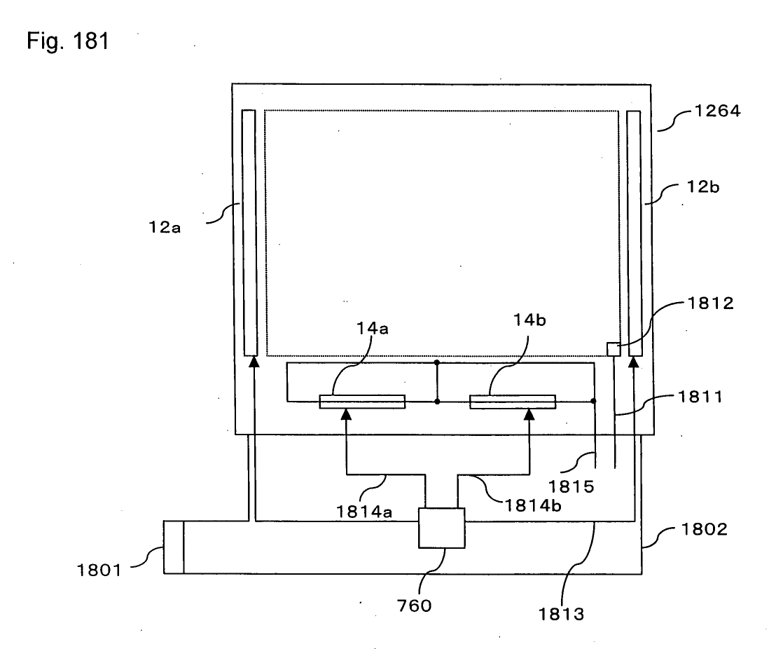

FIG. 181 shows the display panel according to the present invention in more detail. A cathode voltage is applied to cathode wiring 1811, which is connected with a cathode electrode at a cathode connecting location 1812. A gate driver signal 1813 is applied to the gate driver circuits 12 from the controller circuit (IC) 760. Also, a source driver signal 1814 is applied to the source driver ICs 14 from the controller circuit (IC) 760. Anode wiring 1815 is formed on the back surface of the source driver ICs (on a surface of the array) and near the display area of the display panel.

FIG. 181 shows a configuration in which anode or cathode wiring is formed or placed under the source driver ICs 14. However, the present invention is not limited to this. For example, FIG. 587 shows a possible configuration in which cathode wiring 1811 and anode wiring 1815 are formed or placed under the source driver ICs 14. A plurality of anode wires 1815 and cathode wires 1811 (two wires each in FIG. 587) are placed between IC 14a and IC 14b. At least one cathode wire 1811 is connected to a cathode film at the center and an end of the screen 144 and one of the cathode wire(s) 1811 is placed under the IC 14a. At least one of the plurality of anode wires 1815 is connected to the center and an end of the screen 144 and one of the anode wire(s) 1815 is placed under the IC 14b. The plurality of anode wires 1815 are short-circuited near the screen 144.

The configuration in FIG. 587 is characterized in that a plurality of power wires (cathode wires and anode wires) placed or formed on the array board 71 located under the IC chips 14 and that the cathode wires 1811 are placed in contact (connected) with a cathode electrode 36 (see FIGS. 3 and 4) at multiple locations using also wires placed under the IC chips 1. Also, the configuration is characterized in that an anode wire 1815 (placed or formed on the upper side of the screen 144) branching off from anode wiring 5871 (see Vdd in FIG. 1, etc.) of the pixel 16 has feeding points at both ends. By providing feeding points at both ends, it is possible to reduce voltage drops even if the current flowing into Vdd of the pixel 16 is increased.

High wiring resistance of the anode wiring 1815 and cathode wiring 1811 will cause voltage drops, preventing the application of sufficient voltage to the EL element 15 and driver transistor 11a. A method which can solve this problem is provided by an example shown in FIG. 588, in which a thin metal film 5881 of the same material as the cathode electrode 36 is superimposed on thin-film wiring of the cathode wiring 1811 and anode wiring 1815. By laminating the metal material, it is possible to reduce the resistance of the wiring. The thin metal film 5881 of the cathode electrode 36 is produced in the process of superimposing the cathode electrode 36 on the EL elements 15. The above process can be implemented easily by processing masks for masked vapor deposition in which the EL elements 15 are patterned. Specifically, holes are produced in those parts of the masks through which the thin metal film 5881 will be formed.

Although it has been stated with reference to FIG. 588 that the same material as the cathode electrode 36 is superimposed on the thin-film wiring of the cathode wiring 1811 and anode wiring 1815, this is not restrictive and it goes without saying that the same material as the anode electrode may be superimposed. Also, although it has been stated that metal material is superimposed on the thin-film wiring of both cathode wiring 1811 and anode wiring 1815, this is not restrictive and the metal material may be superimposed on one of them. In particular, the anode wiring 1815 is susceptible to voltage drops, and thus it is preferable to reduce its resistance by lamination.

Incidentally, the material to be superimposed is not limited to metal material and may be any material as long as it can reduce resistance. Possible materials include, for example, ITO and carbon. Not only a single layer, but also a plurality of films may be superimposed. Also, an alloy may be superimposed. For example, ITO composing the pixel electrode may be laminated with Li, Al, etc.

EL display apparatus, which have cathode wiring and anode wiring unlike liquid crystal display apparatus, need two gate driver circuits 12a and 12b as illustrated in FIG. 831. This increases the number of wires and complicates their connections. The laying of the wires results in increased bezel width. The need to lead signal lines into the panel 1264 increases the size of the flexible board 1802, resulting directly in increased costs.

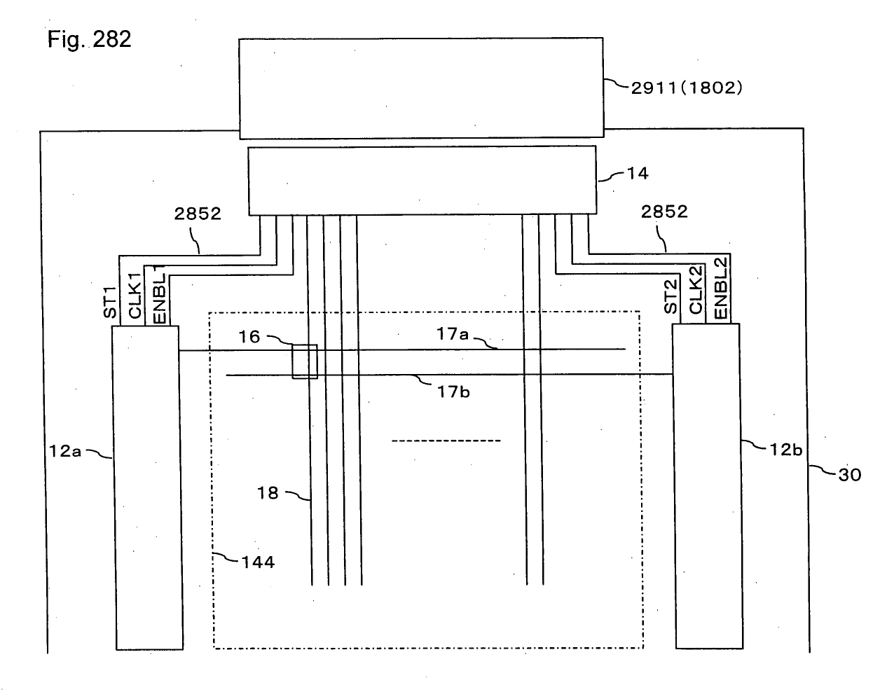

FIG. 282 is an explanatory diagram illustrating a configuration used to solve this problem. Incidentally, for ease of explanation, only ST (signal lines used to apply or transmit start pulses), CLK (signal lines used to apply or transmit clock (shift) pulses), and ENBL (signal lines used to apply or transmit enable pulses) are illustrated in FIG. 282 and the like out of the control signal lines of the gate driver circuits 12. Needless to say, there are actually UD (signal lines used to apply or transmit up/down signals) as well as signal lines used to transmit or supply the Vgh or Vgl voltage.

Incidentally, for ease of explanation, ST(signal lines used to apply or transmit start pulses), CLK(signal lines used to apply or transmit clock (shift) pulses), and ENBL(signal lines used to apply or transmit enable pulses), UD(signal lines used to apply or transmit up/down signals), and other signal lines used to transmit control signals are referred to as control signal lines while the signal lines used to transmit or supply the Vgh or Vgl voltage and similar signal lines are referred to as voltage signal lines.

In FIG. 282, the source driver IC 14 consists of a silicon chip and mounted on the array board 30 using COG (chip-on-glass) technology. On the other hand, the gate driver circuits 12 are formed directly on the array board 30 by polysilicon technology such as low-temperature polysilicon technology, high-temperature polysilicon technology, or CGS.

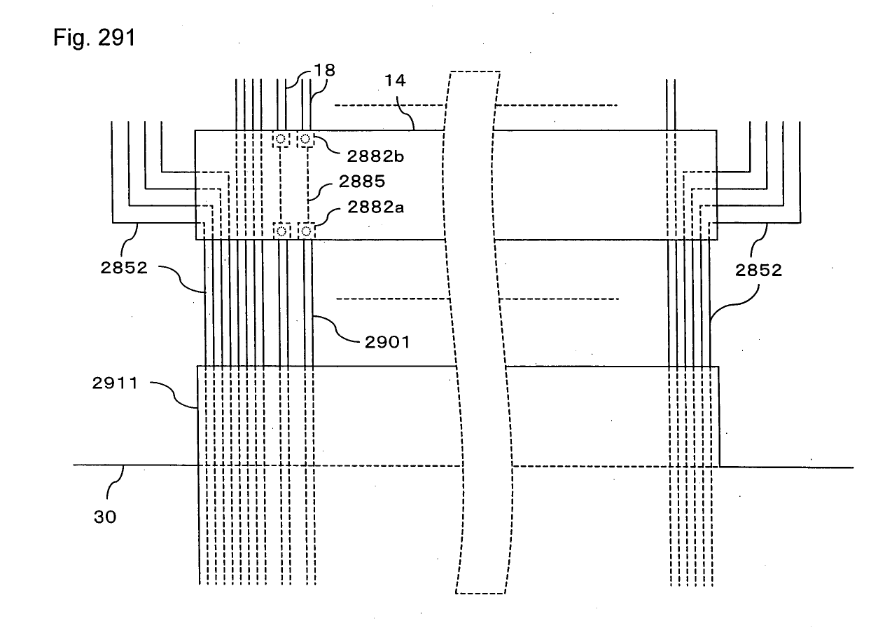

In FIG. 282, the control signal lines (or power signal lines as well) are connected to the gate driver circuits 12 and the like via the back surface of the source driver IC 14 or via a wiring pattern of the source driver IC 14. By connecting the control signal lines or power signal lines via the source driver IC 14, it is possible to reduce the width of the flexible board 2911 (1802) connected with the control signal lines or the like almost to that of the source driver IC 14. This enables cost reductions (see FIG. 291).

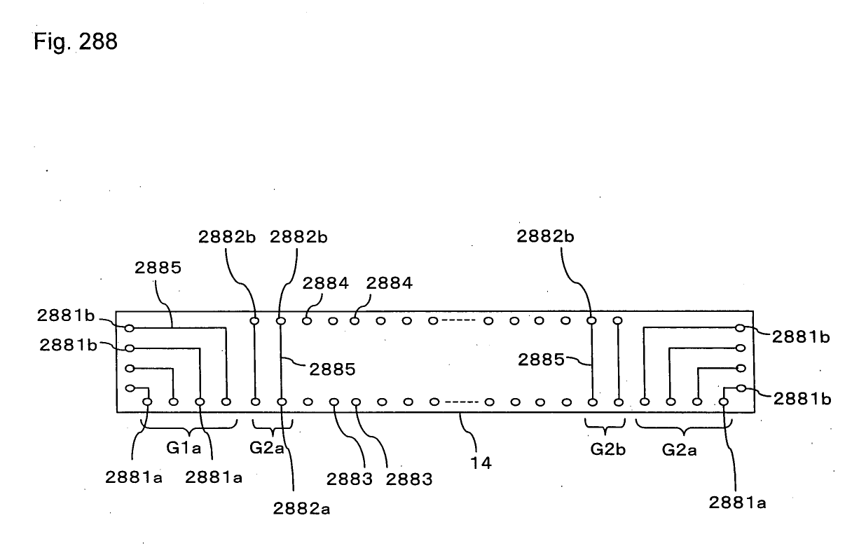

To implement the configuration shown in FIG. 282, the source driver IC 14 according to the present invention is configured as shown in FIG. 288. FIG. 288 is a back view of the source driver IC 14 according to the present invention. Wires 2885 and the like are formed on opposite ends of the chip 14. In FIG. 288, the wires are typical aluminum wires and are formed in the manufacturing process of the ICs. However, the method of forming the wires 2885 and the like is not limited to this. They may be formed by screen printing technology or the like after the completion of the ICs. Needless to say, the wires 2885 and the like may be formed on only one of the chips 14.

The IC 14 has input terminals 2883 for control signal lines as well as terminals 2884 for connection with source signal lines 18. Terminals 2881a for connection with control signal lines are formed or placed on an end of the chip 14. Also, the terminals 2881a are connected with wires 2885, whose other ends are connected with terminals 2881b. The control signal lines connected to an area G1a are connected to terminals 2881b at a longitudinal end of the chip. The power signal lines connected to terminals 2882a are connected to terminals 2882b via wires 2885. It is assumed that the terminals 2882 are connected with anode or cathode wires. Thus, the power signal lines bridge the IC chip and come out of the output side (the side connected with the source signal lines 18) of the IC 14.

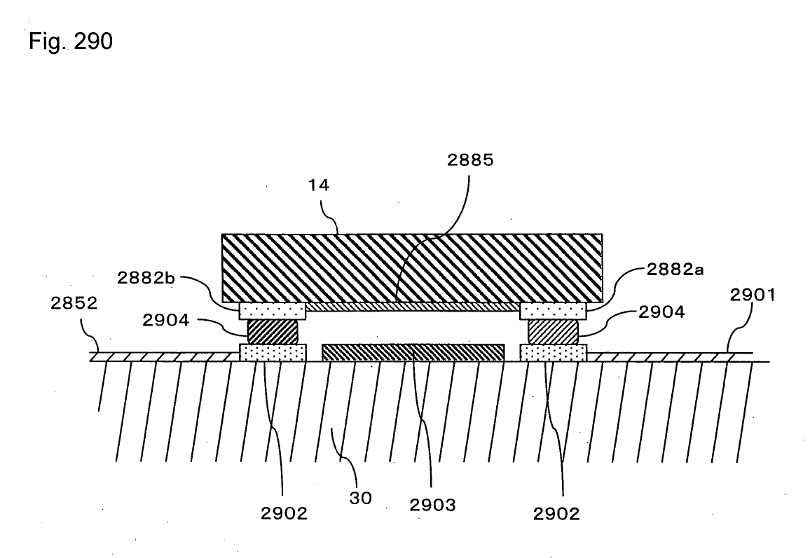

The reason why the IC 14 is bridged by the wires 2885 is that the anode wiring 1815 and the like are often formed on the back surface of the IC 14 to serve as a light-shielding film for the IC 14, as illustrated in FIG. 208, etc. (see also FIG. 290). The anode wiring 1815 formed on the back surface of the IC 14 as a light-shielding film prevents more than in the IC caused by a photoconductive phenomenon. By connecting the control signal lines or power signal lines with the wires 2885, it is possible to eliminate the need to cross wires on the array board 30. This reduces short circuits at intersections and improves manufacturing yields.

Although it has been stated in the example in FIG. 288 that the wires 2885 and the like are formed on the back surface of the IC 14 (facing the array board 30), this is not restrictive. For example, the wires 2885 and the like may be formed or placed on the front surface of the IC chip 14. Needless to say, a flexible board 2911 (1802) on which wires 2885 are formed may be placed in a gap between the IC chip 14 and array board 30.

It has been stated in the above example that the wires 2885 and the like are formed on the source driver IC 14 to bridge signal lines. However, the present invention is not limited to this. Needless to say, the gate driver circuits 12 may be made of silicon chips (gate driver ICs 12) and the wires 2885 and the like may be formed on the back surface and the like of the gate driver circuits 12.

Preferably, a thin film (thick film) of inorganic material or organic material may be formed on the wires 2885. The thin film (thick film) should be at least 0.1 μm thick. Preferably, however, it is 3 μm or less in thickness. The thin film (thick film) protects the wires 2885 and prevents the problem of corrosion and the like. Preferably, the specific inductive capacity of the thin film (thick film) is between 3.5 and 6.0 (both inclusive).

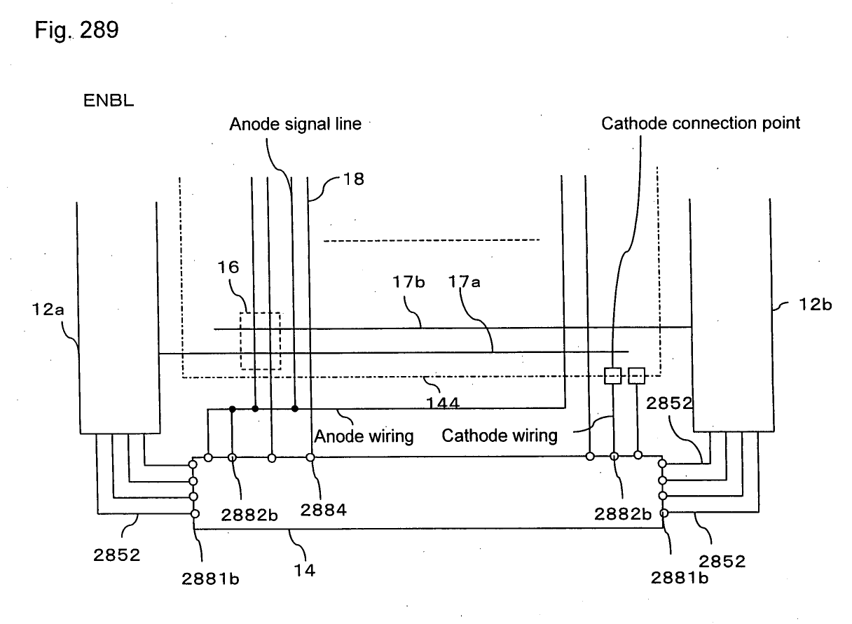

FIG. 289 shows the source driver IC 14 according to the present invention mounted on an array board 30. The power signal line (anode wiring in this example) comes out of the terminals 2882b via wiring 2885 and branches to the pixels 16 in the display area 144. It is brought out from the terminal 2882b on the right end of the IC chip of the cathode wiring and connected to the cathode electrode 36 at a cathode connection point. The control signal line comes out of the terminals 2881b via wiring 2885 on the IC 14 and enters the gate driver circuits 12.

FIG. 290 is a sectional view of the IC 14 mounted on the array board 30. Wires 2885 are formed on the back surface of the IC chip 14 to connect the terminal 2882a and terminal 2882b. A gold bump 2904 is formed on the terminals 2882. The gold bumps 2904 connect terminals 2902 of the array board 30 with the terminals 2882 of the IC 14. Thus, a signal applied to a signal line 2901 is connected electrically with a signal line 2852 via the wire 2885 of the IC 14 and does not cross any conductor wire, such as an anode wire 2903, formed on the array board 30.

As illustrated in FIG. 347, output terminals are laid out such that the wires 2852 running from the source driver circuit (IC) 14 to the gate driver circuits (IC) 12 will not cross each other. The rest of the details has been described with reference to FIG. 282, and thus description thereof will be omitted.

As illustrated in FIG. 358, power wiring (e.g., wiring used to supply the Vgh voltage, Vgl voltage, etc.) 2852b of the gate driver circuits 12 is formed on a surface of the array board 30 and laid (placed or formed) on the underside of the source driver IC 14 constituted of a chip. The anode wiring is also formed or placed on the front surface of the array board 30 facing the back surface of the IC chip 14. The control signal lines of the gate driver circuits 12 are connected via the wires 2885 formed or placed on the source driver IC 14.

The above configuration makes it possible to use the back surface of the IC chip 14 effectively and reduce the bezel width of the panel.

As described above, by bridging the power signal lines or control signal lines using the wires 2885 on the IC 14, it is possible to avoid crossing the wiring formed on the array board 30. Another major advantage is the capability to reduce the size of the flexible board 2911 used to connect signal lines and the like to the panel as illustrated in FIG. 291. Generally, flexible boards 2911 are expensive, and thus the smaller their size, the higher the cost benefits.

As illustrated in FIG. 291, signals and the like are inputted directly to the input signal lines 2901 and 2852 for the IC 14 from the flexible board 2911. Without the wiring 2885 on the IC 14, the control signal lines would have to be bent on an input surface of the array board 30 to avoid the IC 14. Bending the signal lines increases the bezel width of the panel. By connecting the signal lines via the wiring 2885 on the IC 14 as is the case with the present invention, it is possible to reduce the bezel width.

In the example described with reference to FIG. 288, etc., the terminals 2881a and terminals 2881b are connected via the wiring 2885 or the like. That is, the signals inputted in the terminals 2881a are outputted as they are from the terminals 2881b. However, the present invention is not limited to this. Needless to say, for example, a circuit or wiring may be formed or placed between the terminals 2881 to branch, delay, or vary the inputted signals.

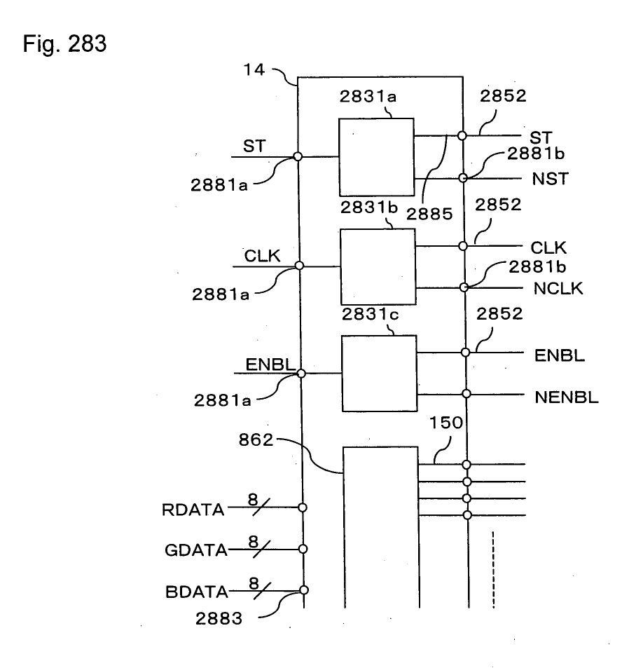

FIG. 283 shows, by way of example, a configuration in which conversion circuits 2831 are formed between the terminals 2881a and terminals 2881b. The conversion circuits 2831 in the example in FIG. 283 are inverted-output generator circuits. The inverted-output generator circuits 2831 generate inverted signals of inputted signals. For example, in the case of an ST signal, they generate a negative ST signal. The negative ST signal will be referred to as NST. More specifically, if the ST is 3 V during a period of 1 H in one frame period and is 0 V during the rest of the frame period, the NST signal is 0 V during the 1H period in the frame period and is 3 V during the rest of the frame period. The above items also apply to the CLK and ENBL signals.

Thus, in FIG. 283, the signals inputted in the terminals 2881a are converted into positive signals and negative signals by the conversion circuits 2831 and outputted through the terminals 2831b. This reduces the number of signals inputted in the source driver IC 14.

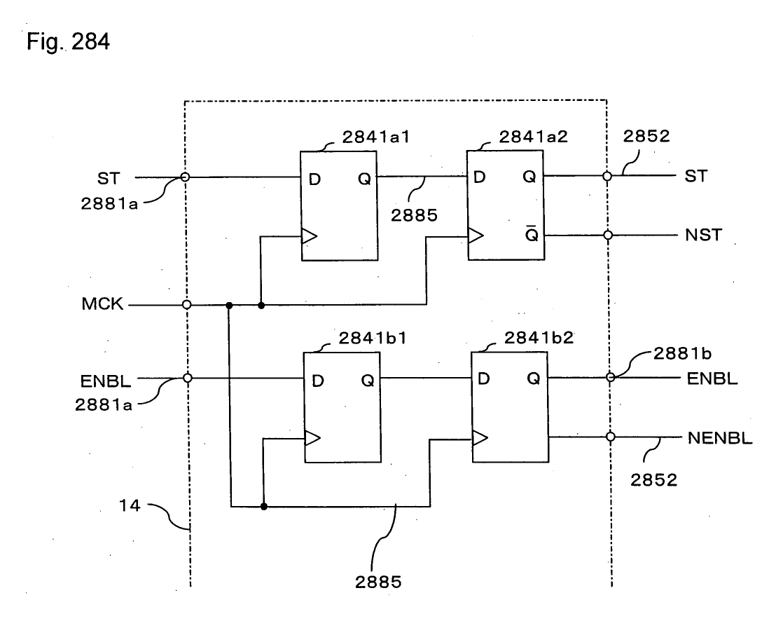

The circuits in FIG. 283 generate inverted outputs, but the present invention is not limited to this. FIG. 284 shows a configuration in which delay circuits 2841 constituted of flip-flop circuits (FF circuits) are formed in the source driver IC 14.

In FIG. 284, the FF circuits 2841 are placed between the terminals 2881a and terminals 2881b by way of example. ST signals and the like are delayed by the FF circuits 2841. It is necessary to adjust the timing to apply a programming current to the source signal line 18 and the timing to apply a turn-on voltage to the gate signal lines 17a by synchronizing the control signals (ST, CLK, etc.) of the gate driver circuits 12 with the latch circuit 862 and the like of the source driver circuit (IC) 14. The timing adjustment is performed using the FF circuits 2841 and the like. This configuration makes it easy to adjust the timing to output the control signals from the controller circuit (IC) 760.

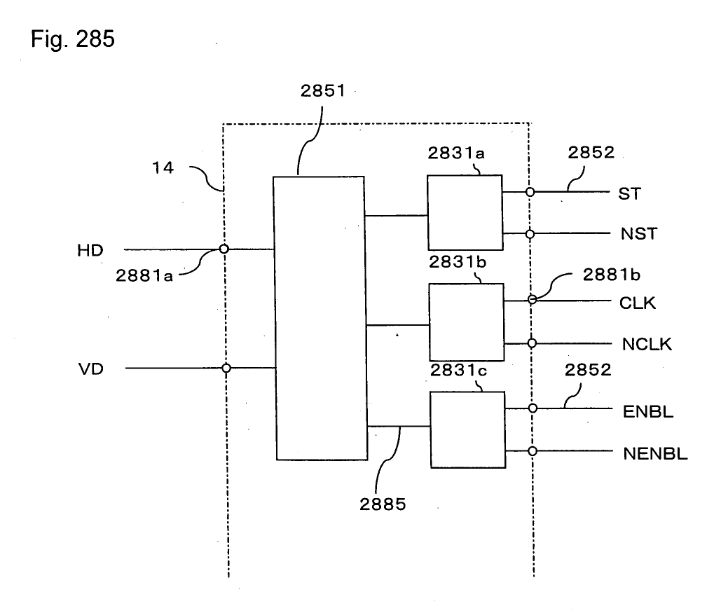

Besides, control signals (ST, CLK, ENBL, etc.) may be generated from HD (horizontal scanning signal) and VD (vertical scanning signal) as illustrated in FIG. 285. That is, a signal generator circuit 2851 is formed or placed in the source driver circuit (IC) 14. Control signals (ST, CLK, ENBL, etc.) are generated by the signal generator circuit 2851 using HD (horizontal scanning signal), VD (vertical scanning signal), etc. This configuration makes it possible to further reduce the number of signal lines entering the source driver IC 14.

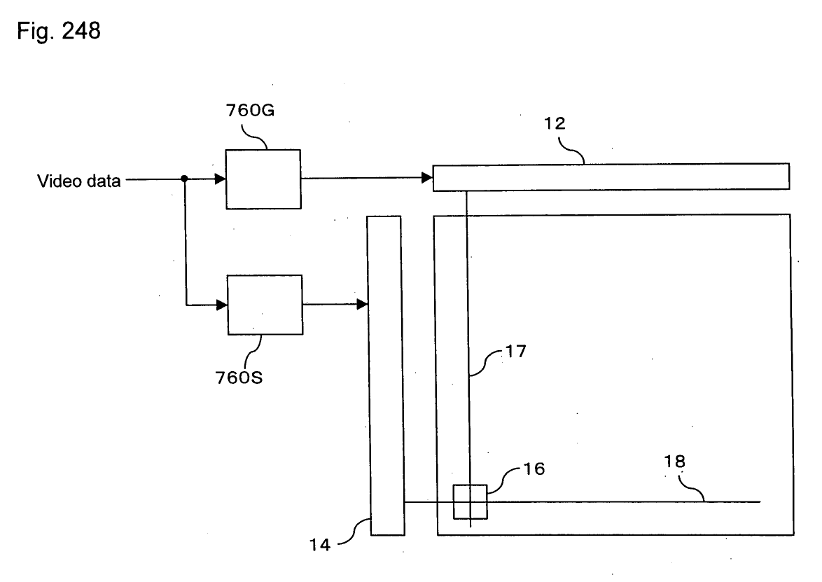

In FIGS. 14, 248, etc., a gate driver circuit 12 is placed on one side of the screen. In FIGS. 30, 83, 85, 180, 181, 202, 211, 212, 215, 217, 219, 223, 225, 260, 265, 281, 282, 289, 316, 319, 320, 327, 347, 358, etc., gate driver circuits (IC) 12a and 12b are placed on the left and right of the screen 144, respectively. However, the display panel (display apparatus) according to the present invention is not limited to this. Both gate driver circuits (IC) 12a and 12b may be placed on both the left and right of the screen 144 as illustrated in FIG. 373.

FIG. 373 shows that a gate driver circuit 12a1 which drives gate signal lines 17a is placed or formed at the left end of the screen 144, a gate driver circuit 12a2 which drives the gate signal lines 17a is placed or formed at the right end of the screen 144. A gate driver circuit 12b1 which drives gate signal lines 17b is placed or formed at the left end of the screen 144, and a gate driver circuit 12b2 which drives the gate signal lines 17b is placed or formed at the right end of the screen 144.

In the configuration in which a gate driver circuit 12a1 which drives gate signal lines 17a is placed or formed at the left end of the screen 144, a gate driver circuit 12a2 which drives the gate signal lines 17a is placed or formed at the right end of the screen 144, a gradation gradient may occur between the left and right of the screen 144. For example, if a gate driver circuit 12b is formed only at the right end of the screen 144, signal waveforms applied to the gate signal lines 17b become blunt at the left end of the screen 144, causing images to dim at the left end of the screen 144.

The problem of gradation gradient on the screen 144 can be eliminated if a gate driver circuit 12a1 which drives gate signal lines 17a is placed or formed at the left end of the screen 144, a gate driver circuit 12a2 which drives the gate signal lines 17a is placed or formed at the right end of the screen 144, a gate driver circuit 12b1 which drives gate signal lines 17b is placed or formed at the left end of the screen 144, and a gate driver circuit 12b2 which drives the gate signal lines 17b is placed or formed at the right end of the screen 144 as illustrated in FIG. 373.

FIG. 373 shows that a gate driver circuit 12a1 which drives gate signal lines 17a is placed or formed at the left end of the screen 144. A gate driver circuit 12a2 which drives the gate signal lines 17a is placed or formed at the right end of the screen 144. A gate driver circuit 12b1 which drives gate signal lines 17b is placed or formed at the left end of the screen 144, and a gate driver circuit 12b2 which drives the gate signal lines 17b is placed or formed at the right end of the screen 144. However, the present invention is not limited to this. For example, either the gate driver circuits 12a or gate driver circuits 12b may be placed on the left and right of the screen 144. Alternatively, the gate driver circuits 12b may be placed on the left and right of the screen 144 with the gate driver circuit 12a placed on either the left or right of the screen 144.

A hybrid configuration may be implemented in which the gate driver circuit 12a1 is mounted directly on the array board 30 using polysilicon technology and the gate driver circuit 12a2 consisting of a silicon chip is mounted on the array board 30 using COG technology. A hybrid configuration may be implemented in which the gate driver circuit 12b1 is mounted directly on the array board 30 using polysilicon technology and the gate driver circuit 12b2 consisting of a silicon chip is mounted on the array board 30 using COG technology. Also, combinations of the above configurations are available.

The items described with reference to FIGS. 288 to 291 also apply to the configuration in FIG. 373. FIG. 374 shows a configuration implemented by the application of the example described with reference to FIGS. 288 to 291.

In FIG. 374, control signals for the gate driver circuits 12 inputted through the terminals 2883 are bifurcated by internal wiring 2885 of the source driver circuit 14 and transmitted to the gate driver circuits 12 placed on the left and right of the screen 144. The internal wiring 2885 is connected between two terminals 2881b1 as well as between two terminals 2881b2. Signals for controlling the gate driver circuits 12b are outputted through terminals 2882b1 and signals for controlling the gate driver circuits 12a are outputted through terminals 2882b2.

Although it has been stated with reference to FIG. 374 that the signals for controlling the gate driver circuits 12 are bifurcated by the internal wiring 2885 of the source driver circuit 14, this is not restrictive. Needless to say, the signals may be bifurcated by wiring formed on an array 30 surface under the IC 14 as described with reference to FIG. 291 and the like.

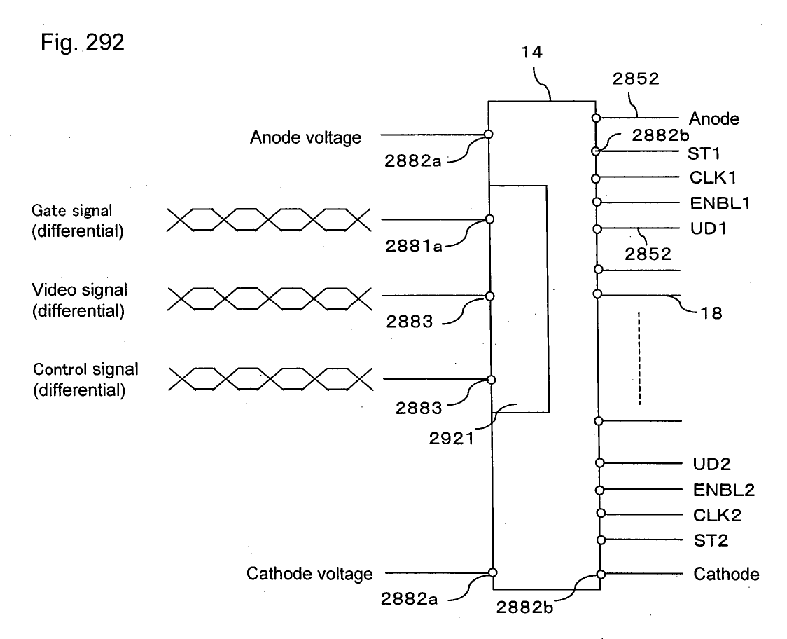

An example in which signals are inputted to the source driver circuit 14 as differential signals has been described with reference to FIG. 190. An example in which signals are supplied as differential signals has also been described with reference to FIGS. 81, 82, etc. Similarly, as illustrated in FIG. 292, gate signals (control signals (ST, ENBL, etc.) for the gate driver circuits 12) may also be applied as differential signals to the source driver circuit 14. The differential signals are converted into parallel signals by a differential-parallel converter circuit 2921.

In the example in FIG. 292, the anode voltage and cathode voltage which are power signals are inputted in the terminals 2882a and the gate signal (differential) which controls the gate driver circuits 12 is inputted in the terminal 2881a. The video signal (differential) and control signal (differential) are inputted in the terminal 2883. Needless to say, the gate signal, video signal, and control signal may be provided as twisted-pair differential signals. Also, the gate signal and the like may be transmitted through a fine-line coaxial cable.

Needless to say the above example can be applied to other the terminal (2883, 2884, 2882, etc.) of the present invention.

The application of the signals as differential signals in the configuration in FIG. 292 makes it possible to reduce the number of signal lines. By forming the wiring 2885 on the IC 14 as shown in FIGS. 288, 290, etc., it is possible to prevent signal lines from crossing each other. The above configuration produces effect by mounting the gate driver circuits 12 and the like on the array board 30 using polysilicon technology and mounting the source driver IC 14 consisting of a silicon chip and the like on the array board 30 using COG technology.

In the above example, a single IC 14 is used in the panel 1264. However, the present invention is not limited to this. For example, as illustrated in FIG. 316, further, the panel 1264 may have two (or more) IC chips 14 mounted on the array board 30 of the display panel 1264. Power signal lines and/or control signal lines are brought out from both ends of each IC 14 and differential-parallel converter circuits 2921 are formed or placed on-both ends of each IC 14.

A logic signal (voltage level) is applied as a selector signal GSEL to select which of the differential-parallel converter circuits 2921 to operate. In FIG. 316, the differential-parallel converter circuit 2921a1 operates on the IC chip 14a to output control signals for the gate driver circuit 12a, etc. The differential-parallel converter circuit 2921b2 operates on the IC chip 14b to output control signals for the gate driver circuit 12b, etc.

It is stated herein by way of example that differential signals are outputted from the controller circuit (IC) 760 and received by the source driver circuit (IC) 14 as illustrated in FIG. 528. A constant-current circuit Icon is constructed on the controller circuit (IC) 760 to control transistors Ml and M2, and thereby output signals TxV+and TxV−from terminals 2883c. The signals outputted from the terminals 2883c are transmitted through wiring on the flexible board, wiring on the printed board, cables, coaxial wiring, etc. and applied to input terminals 2883a of the source driver circuit (IC) 14.

The signals applied to the terminals 2883a are applied as a differential signal (RxV+, RxV−) to a comparator 5281 and restored to a logic signal TDATA. Resistors RT1 and RT2 are installed externally to the source driver circuit (IC) 14. A path for the Icon current is terminated.

The resistors RT1 and RT2 may be built into the source driver circuit (IC) 14. Needless to say, the source driver circuit (IC) 14 maybe formed directly on the array board 30 by polysilicon technology (such as low-temperature polysilicon technology, high-temperature polysilicon technology, or CGS).

The resistance of the resistor RT1 and the like is adapted to the impedance and the like of a transmission path. According to the present invention, the resistance of the resistors RT is between 100 and 300 Ω (both inclusive).

Switches (ST1 and ST2) built into the source driver circuit (IC) 14 may be, for example, analog switches. The switches ST are turned on and off according to the logic level applied to an input terminal (not shown) of the source driver circuit (IC) 14.

The switches ST are not limited to typical switches. They may be obtained by causing a short circuit selectively by means of aluminum wiring according to specification of signals inputted in the display panel in an IC process.

This is because a selection between a differential input configuration described with reference to FIG. 529 and CMOS level input configuration described with reference to FIG. 530 has been made in advance according to the specification of signals applied to the display panel. That is, it is rarely necessary to switch between a CMOS level signal and differential signal using the switches ST.

Of course, it goes without saying that the termination resistors RT may be connected to input terminals of the comparator 5281 or paths leading to output terminals of the controller circuit (IC) 760 as illustrated in FIG. 529 without installing switches ST. One termination resistor RT may be placed, installed, or constructed in each wire even if there are two or more source driver circuits (ICs) 14.

The termination resistors RT may be constituted of regulators whose resistance can be varied or changed. Needless to say, the configurations shown in FIGS. 368, 369, and 372 may also be used. Besides, the resistors RT may be trimmed to target values.

In the configuration in FIG. 528, when switches ST (ST1 and ST2) are turned on (closed), a differential signal is inputted in the source driver circuit (IC) 14. When switches ST (ST1 and ST2) are turned off (opened), a CMOS or TTL logic signal is inputted. In the case of CMOS or TTL level input, a fixed DC voltage for use to determine logic level is applied to the negative terminal of the comparator 5281 and a logic signal is applied to the positive terminal as illustrated in FIG. 530. When the signal level at the positive terminal is higher than the signal level at the negative terminal, the logic level is determined to be high (H). When the signal level at the positive terminal is lower than the signal level at the negative terminal, the logic level is determined to be low (L). To determine the logic level, it is preferable to configure the comparator 5281 to have hysteresis characteristics. Incidentally, for ease of explanation, it is assumed herein that CMOS level signals are used.

FIG. 528 illustrates that signals from the controller circuit (IC) 760 are applied to a single source driver circuit (IC) 14. Actually, however, signals from the controller circuit (IC) 760 are applied to a plurality of source driver circuits (IC) 14 as illustrated in FIGS. 529, 530, etc.

In FIG. 529, input signals are differential signals. Termination resistors RT are placed in output wires from the controller circuit (IC) 760 (e.g., differential signals D0+/D0−, D1+/D1−, . . . , D7+/D7− for a total of eight bits). The controller circuit (IC) 760 drives a plurality of source driver circuits (IC).14. The comparators 5281 in the source driver circuits (IC) 14 convert differential signals for respective bits into logic signals (TDATA) for the respective bits. TDATA are inputted in driver circuits 5291. Possible configurations of the driver circuits 5921 include those described with reference to FIGS. 77, 43, 45, 48, 46, 50, 56, 60, 393, 394, 495, 508, etc. The signals processed or controlled by the driver circuits 5291 are outputted from terminals 155 and applied to the source signal lines 18 of the display panel.

Although FIGS. 528, 529, and 530 illustrate input of video data (D0 to D7), this is not restrictive. Needless to say, the above items also apply to the precharge signal illustrated in FIG. 361, the control signals illustrated in FIG. 425, the gate driver control signals illustrated in FIG. 505, and so on.

FIG. 530 shows a configuration for CMOS level signals (logic signals). A direct current voltage (DC voltage) V0 is applied to the negative terminals (or positive terminals) of the comparators 5281. The logic signals D0 to D7 are determined to be high when their signal level is higher than the V0 voltage. The logic signals D0 to D7 are determined to be low when their signal level is lower than the V0 voltage. Thus, in the configuration in FIG. 530, the comparators 5281 function as buffers.

The source driver circuit (IC) 14 for the configuration in FIGS. 528 and 529 has both differential interface (differential IF) 2921a and CMOS (TTL) interface (CMOS IF) 2921b as illustrated in FIG. 531. Thus, interface specification can be selected according to service condition. In FIG. 531(a), the controller circuit (IC) 760 outputs CMOS level signals. The source driver circuit (IC) 14 uses the CMOS IF for use with the configuration in FIG. 530.

In FIG. 531(b), the controller circuit (IC) 760 outputs CMOS level signals. The configuration in FIG. 531(b) includes a mode converter circuit (IC) 5311. The mode converter circuit (IC) 5311 has a function to convert CMOS signals into differential signals. The controller circuit (IC) 760 outputs CMOS signals through the CMOS IF 2921b. The mode converter circuit (IC) 5311 converts the signals received through the CMOS IF 2921b into differential signals and outputs them through the differential IF 2921a. The differential signals outputted from the differential IF 2921a are inputted in the differential IF 2921a of the source driver circuit (IC) 14.

Thus, with the circuit configuration shown in FIG. 529, the source driver circuit (IC) 14 can receive both differential signals and CMOS (TTL) level signals.

Incidentally, although FIG. 316 illustrates that the differential-parallel converter circuits 2921 are placed on both ends of the IC chip 14, this is not restrictive. It is alternatively possible to use a single differential-parallel converter circuit 2921 in a configuration in which control signal lines and the like can be branched to both ends of the chip 14 via wiring 2851. What is important is that power signal lines or control signal lines can be brought out from both ends of the IC chip 14. Also, if a plurality of IC chips 14 are mounted on an array board 30 as shown in FIG. 316, it is important to be able to select whether or not to produce outputs from the power signal lines or control signal lines at both ends of the IC chips 14 (to ensure that image display will not be affected even if signals or the like are output from both ends). A GESL signal is used for the selection.

Output signals 2852 to the gate driver circuits 12 from different source driver circuits (ICs) 14 may be controlled separately using Gcntl signals as illustrated in FIG. 601. In FIG. 601, when the Gcntl1a signal for the source driver circuit (IC) 14a goes high (H), a control signal is outputted from the output terminal 2881b1 of the source driver circuit (IC) 14a to the gate driver circuit 12a.

When the Gcntl1a signal for the source driver circuit (IC) 14a goes low (L), the output terminal 2881b1 of the source driver circuit (IC) 14a goes into a high impedance state. When the Gcntl1b signal for the source driver circuit (IC) 14a goes low (L), the output terminal 2881b2 of the source driver circuit (IC) 14a goes into a high impedance state. In FIG. 601, the output terminal 2881b2 of the source driver circuit (IC) 14a has no signal to output, and thus the Gcntl1b signal remains low (L).

When the Gcntl2b signal for the source driver circuit (IC) 14b goes high (H), a control signal is outputted from the output terminal 2881b2 of the source driver circuit (IC) 14b to the gate driver circuit 12b. When the Gcntl2a signal for the source driver circuit (IC) 14b goes low (L), the output terminal 2881b1 of the source driver circuit (IC) 14b goes into a high impedance state. In FIG. 601, the output terminal 2881b1 of the source driver circuit (IC) 14b has no signal to output, and thus the Gcntl2a signal remains low (L).

In the above example, two source driver circuits (IC) 14 are used in one display panel. However, the present invention is not limited to this. Three or more source driver circuits (IC) 14 may be used. If three or more source driver circuits (IC) 14 are used, two output terminals 2881b of at least one source driver circuit (IC) 14 go into a high impedance state. Needless to say, the high impedance state is brought about by manipulating the GSEL and Gcntl signals.

According to the present invention, the same source driver IC 14 can be used regardless of whether a single source driver IC 14 or multiple source driver ICs 14 are mounted on the array 30. This also applies even when a single source driver IC is used and gate driver circuits 12 are formed or placed on one end of the screen 144.

Depending on circumstances, this may be in the input direction. For example, start pulses (ST) outputted from a gate driver circuit 12 may be inputted in a terminal 2821b and then outputted from a terminal 2821a. The output pulses are inputted in the control IC 760. They allow the control IC 760 to monitor the operation of the gate driver circuits 12 and determine whether it is normal.

Although it has been stated herein that the source driver IC 14 is made of silicon and the like and mounted on the array board 30 using COG technology or the like, this is not restrictive. The source driver IC 14 may be mounted using TAB or COF technology. Alternatively, the source driver circuit (IC) 14 may be formed directly on the array board 30 by polysilicon technology. The last method is especially effective for the configuration in FIG. 316, etc. On the other hand, although it has been stated that the IC chip 14 is mounted on the array board 30 (substrate on which the pixel electrode and the like are formed), this is not restrictive. It may be formed on an opposing substrate and connected with source signal lines 18 and the like formed on the array board 30. Needless to say, the above is also applicable to other examples of the present invention.

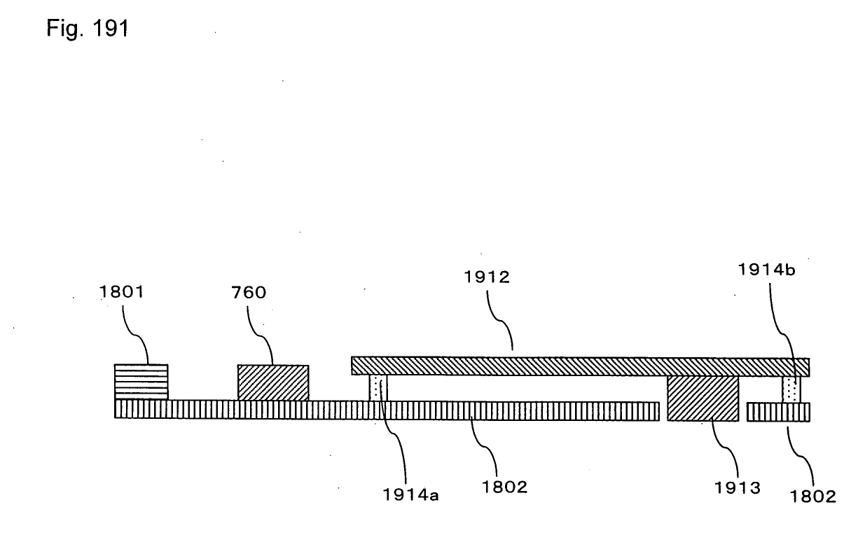

FIG. 191 is a sectional view of a flexible board 1802. A power supply module 1912 is connected to the flexible board 1802 via terminals 1914. A coil (transformer) 1913 is mounted on the power supply module 1912, being inserted in a hole produced in the flexible board 1802. This configuration makes it possible to obtain a generally thin panel module.

The substrate 1802 may be placed such that the control circuit (IC) 760, power supply circuit (IC), and other components mounted on it will fit into a recess formed in an encapsulation substrate (sealing lid) 40 as illustrated in FIG. 585. The configuration in FIG. 585 makes the panel module compact.

When the driver transistor 11a and selection transistors (11b and 11c) of the pixel 16 are P-channel transistors as shown in FIG. 1, a penetration voltage is generated. This is because potential fluctuations of the gate signal line 17a penetrates to a terminal of the capacitor 19 via G-S capacitance (parasitic capacitance) of the selection transistors (11b and 11c). When the P-channel transistor 11b turns off, the voltage goes high (Vgh), shifting the terminal voltage of the capacitor 19 slightly to the Vdd side. Consequently, the voltage at the gate (G) terminal of the transistor 11a rises, resulting in more intense black display. This makes it possible to achieve a proper black display.

This example is configured to vary the potential of the capacitor 19 via G-S capacitance (parasitic capacitance) of the transistor 11b, and thereby achieve proper black display. However, the present invention is not limited to this. For example, a capacitor 19b which generates a penetration voltage may be formed as illustrated in FIG. 595, where FIG. 595(a) shows a configuration in which the capacitor 19b is added to the pixel configuration in FIG. 1. Preferably the two electrodes of the capacitor 19b are formed as an electrode layer which constitutes a gate signal line 17 for the transistors 11 and an electrode layer which constitutes (forms) a source signal line 18. Preferably, the capacitance of the capacitor 19b is between ¼ and 1/1 (both inclusive) of the capacitance of a capacitor 19a.

FIG. 595(b) shows a current-mirror pixel configuration in which the capacitor 19b generates a penetration voltage. In this example, it is assumed for ease of explanation that the transistors 11 are P-channel transistors.

FIG. 596 shows a drive waveform of the gate driver 17a in the pixel configuration in FIG. 595. The transistors 11b and 11c, which are P-channel transistors, turn on at the Vgl voltage (L voltage) and turn off at the Vgh voltage (H voltage). As illustrated in FIG. 596, each pixel row is selected for one horizontal scanning period (1 H).

In FIG. 596, the voltage applied to the gate signal line 17a changes from Vgh to Vgl at point A, at which the capacitor 19b causes voltage to penetrate into the capacitor 19a. Consequently, the gate terminal potential of the driver transistor 11a shifts toward a lower voltage. This causes a little large current to flow through the driver transistor 11a for a short period. However, since a programming current flows from the driver transistor 11a to the source signal line 18 for a 1H period from point A to point B, even if a large current flows for a short period after point A, it is soon replaced by the regular programming current.

The voltage applied to the gate signal line 17a changes from Vgl to Vgh at point B, at which the capacitor 19b causes voltage to penetrate into the capacitor 19a. Consequently, the gate terminal potential of the driver transistor 11a shifts toward a higher voltage. This makes the current flowing through the driver transistor 11a smaller than the programming current.

After point B, the transistors 11b and 11c are turned off, and a current smaller than the programming current flows through the driver transistor 11a for one frame period. A voltage shift caused by a penetration voltage is conceptually shown in FIG. 597. The capacitor 19b causes a V-I curve of the driver transistor 11a to shift from solid line to dotted line. Along with the shift to the dotted V-I curve, the current applied to the EL element 15 by the driver transistor 11a is reduced. As the amount of voltage shift is constant, proper black display can be achieved especially in a low gradation range.

This is because the amount of shift in penetration voltage due to the capacitor 19b and the like is constant and the Vgh voltage and Vgl voltage have fixed values. In current driving mode (current programming mode), the programming current for low gradations is small, making it difficult to charge and discharge the parasitic capacitance of the source signal lines 18. However, as illustrated in FIG. 595, the present invention can relatively increase the programming current applied to the source signal line 18, making the current passed through the EL element 15 by the driver transistor 11a smaller than the programming current. That is, a minute programming current can be written into the pixel 16.

On the other hand, the penetration voltage can be varied by varying the Vgh voltage, Vgl voltage, or potential difference between the Vgh voltage and Vgl voltage. For example, a drive method is available which varies or manipulates the Vgh voltage and Vgl voltage according to a lighting ratio (described later). Also, the capacitance of the capacitor 19b or anode voltage Vdd can be varied. For example, a drive method is available which varies or manipulates the anode voltage (Vdd) according to the lighting ratio (described later). By varying or changing these voltages, it is possible to control the magnitude of the penetration voltage and the amount of current passed by the driver transistor 11a, resulting in a proper black display.

Since the magnitude of the penetration voltage is constant regardless of gradation numbers, the proportion of reduction in the amount of programming current is relatively small in a low gradation region.

Consequently, the lower the gradation region, the better the black display.

In the example in FIGS. 595, 596, etc., it is important that the driver transistor 11a, transistor 11b, and the like are P-channel transistors. It is also important that the transistors 11 turn off when the signal applied to the gate signal line 17a is at a voltage (Vgh) close to the anode voltage Vdd, and turn on when the signal applied to the gate signal line 17a is at a voltage (Vgl) close to the cathode voltage. Also, it is important that when a pixel row is selected and then des elected, the value of the current written into each pixel should be held until the pixel row is selected in the next frame (field).

In the above example (FIG. 595, etc.), the transistor 11a is a P-channel transistor. However, the present invention is not limited to this. For example, the technical idea of the present invention is also applicable even when the transistor 11a is an N-channel transistor as illustrated in FIG. 598. FIG. 598 shows a configuration in which the penetration voltage is generated by the capacitor 19b. Basically, this is an N-channel version of the configuration shown in FIG. 595(a).

A drive waveform of the gate driver 17a in the pixel configuration in FIG. 598 is shown in FIG. 599. The transistors 11b and 11c, which are N-channel transistors, turn off at the Vgl voltage (L voltage). On the other hand, the transistors 11b and 11c turn on at the Vgh voltage (H voltage). As illustrated in FIG. 599, each pixel row is selected for one horizontal scanning period (1 H).

In FIG. 599, the voltage applied to the gate signal line 17a changes from Vgl to Vgh at point A, at which the capacitor 19b causes voltage to penetrate into the capacitor 19a. Consequently, the gate terminal potential of the driver transistor 11a shifts toward a higher voltage. This causes a little large current to flow through the driver transistor 11a for a short period. However, since a programming current flows from the driver transistor 11a to the source signal line 18 for a 1H period from point A to point B, even if a large current flows for a short period after point A, it is soon replaced by the regular programming current.

The voltage applied to the gate signal line 17a changes from Vgh to Vgl at point B, at which the capacitor 19b causes the gate terminal potential of the driver transistor 11a to shift toward a lower voltage. This makes the current flowing through the driver transistor 11a from the EL element 15 smaller than the programming current applied to the source signal line 18.

After point B, the transistors 11b and 11c are turned off, and a current smaller than the programming current flows through the driver transistor 11a for one frame period. A voltage shift caused by a penetration voltage is conceptually shown in FIG. 600. Mainly the capacitor 19b causes a V-I curve of the driver transistor 11a to shift from solid line to dotted line. Along with the shift to the dotted V-I curve, the current applied to the EL element 15 by the driver transistor 11a is reduced. As the amount of voltage shift is constant, proper black display can be achieved especially in a low gradation range.

In the example in FIGS. 598, 599, etc., it is important that the driver transistor 11a, transistor 11b, and the like are N-channel transistors. It is also important that the transistors 11 turn on when the signal applied to the gate signal line 17a is at a voltage (Vgh) close to the anode voltage Vdd, and turn off when the signal applied to the gate signal line 17a is at a voltage (Vgl) close to the cathode voltage.

A certain proportion of the voltage applied to the gate signal line 17a is applied to the gate terminal of the driver transistor 11a as a penetration voltage by the capacitors 19 and the like. The current passed through (flowing through) the driver transistor 11a due to the penetration voltage is smaller than the programming current written into the source signal line 18. This results in a proper black display.

However, although a completely black display can be achieved in the 0th gradation, it is difficult to display the 1^{st} gradation. In other cases, a large gradation jump may occur between the 0th and 1^{st} gradations or less of shadow detail may occur in a particular gradation range.

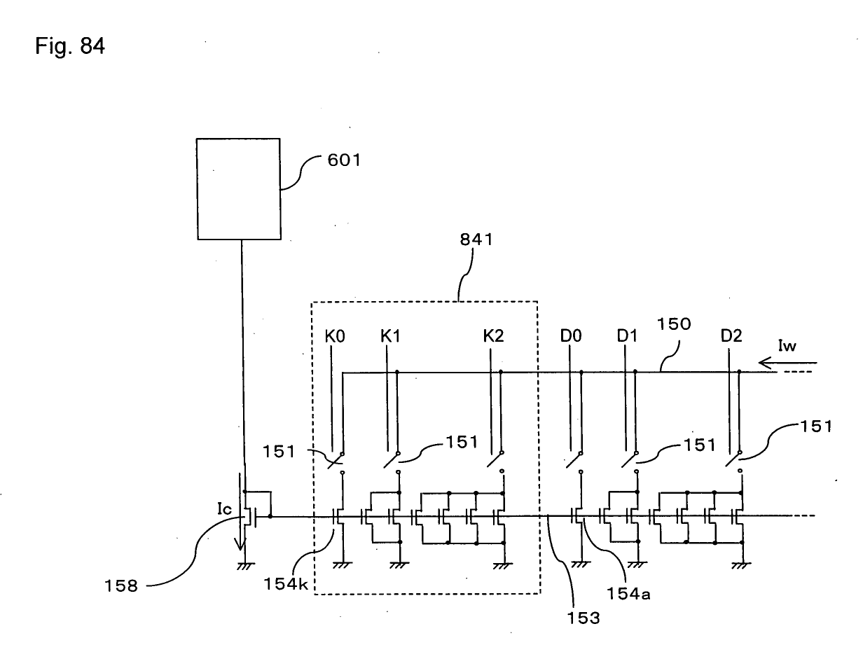

To solve this problem, an example with an appropriate configuration is shown in FIG. 84. This configuration is characterized by comprising a function to pad output current values. A main purpose of a padder circuit 841 is to make up for the penetration voltage. It can also be used to adjust black levels so that some current (tens of nA) will flow even if image data is at black level 0.

Basically, FIG. 84 is the same as FIG. 15 except that the padder circuit 841 has been added (enclosed by dotted lines in FIG. 84) to the output stage. In FIG. 84, three bits (K0, K1, and K2) are used as current padding control signals. The three bits of control signals make it possible to add a current value 0 to 7 times larger than the current value of grandchild current sources to output current. Although it has been stated that the current padding control signal consists of three bits, this is not restrictive. Needless to say, it may consist of more than or less than four bits.

A basic overview of the source driver circuit (IC) 14 according to the present invention has been provided above. Now, the source driver circuit (IC) 14 according to the present invention will be described in more detail.

The current I (A) passed through the EL element 15 and emission brightness B (nt) have a linear relationship. That is, the current I (A) passed through the EL element 15 is proportional to the emission brightness B (nt). In current driving, each step (gradation step) is provided by current (unit transistor 154 (single-unit)) Human vision with respect to brightness has square-law characteristics. In other words, quadratic brightness changes are perceived to be linear brightness changes. However, according to the linear relationship as indicated by the solid line a in FIG. 62, the current I (A) passed through the EL element 15 is proportional. to the emission brightness B (nt) both in low brightness and high brightness regions.

Thus, if brightness is varied step by step (at intervals of one gradation), brightness changes greatly in each step (less of shadow detail occurs) in a low gradation part (black area). In a high gradation part (white area), since brightness changes coincide approximately with a linear segment of a quadratic curve, the brightness is perceived to change at equal intervals. Thus, how to display a black display area, in particular, becomes a problem in current driving (in which each step is provided by an increment of current) (i.e., in a current-driven source driver circuit (IC) 14).

To solve this problem, the slope of output current is decreased in the low gradation region (from gradation 0 (complete black display) to gradation R1) and the slope of output current is increased in the high gradation region (from gradation R1 to the highest gradation R) That is, a current increment per gradation (in each step) is decreased in the low gradation region and a current increment per gradation (in each step) is increased in the high gradation region. By varying the amount of change in current between the low gradation region and high gradation region, it is possible to bring gradation characteristics close to a quadratic curve, and thus eliminate less of shadow detail in the low gradation region.

Incidentally, although two current slopes—in the low gradation region and high gradation region—are used in the above example, this is not restrictive. Needless to say, three or more slopes may be used. Needless to say, however, the use of two slopes simplifies circuit configuration. Preferably, a gamma circuit is capable of generating five or more slopes.

A technical idea of the present invention lies in the use of two or more values of current increment per gradation step in a current-driven source driver circuit (IC) and the like (basically, circuits which use current outputs for gradation display. Thus, display panels are not limited to the active-matrix type and include the simple-matrix type).

In EL and other current-driven display panels, display brightness is proportional to the amount of current applied. Thus, the source driver circuit (IC) 14 according to the present invention can adjust the brightness of the display easily by adjusting a reference current which provides a basis for a current flowing through one current source (one unit transistor) 154.

In EL display panels, light emission efficiency varies among R, G, and B and color purity deviates from that of the NTSC standard. Thus, to obtain an optimum white balance, it is necessary to optimize ratios among R, G, and B. The adjustment is performed by adjusting respective reference current for R, G and B. For example the reference current for R is set to 2 μA, the reference current for G is set to 1.5 μA, and the reference current for B is set to 3.5 μA. Preferably, at least one reference current out of the reference currents for different colors can be changed, adjusted, or controlled.

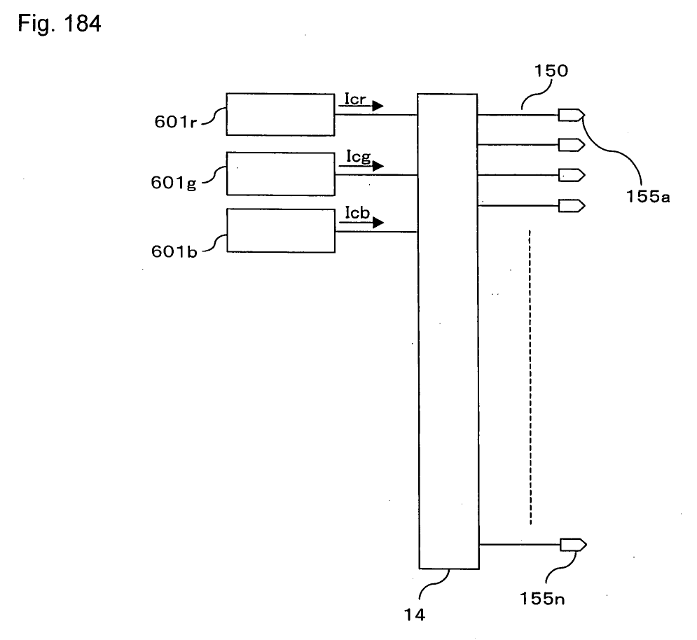

The white balance is achieved through adjustment of the reference currents Ic (which consist of Icr for red, Icg for green, and Icb for blue) as illustrated in FIG. 184. However, white balance will be shifted due to variations in characteristics of the transistors 158. This may vary with the IC chip. In spite of this problem, white balance can be achieved through adjustment of a reference current circuit 601r (for red), reference current circuit 601g (for green), and reference current circuit 601b (for blue) in FIG. 184 using a trimming technique described with reference to FIG. 164. This adjustment can be made very easily particularly in the case of current driving because there is a linear relationship between the current I passed through the EL and brightness.

In the case of current driving, the current I passed through the EL element and brightness have a linear relationship. To adjust white balance through a mixture of R, G, and B, it suffices to adjust the reference currents for R, G, and B at only one predetermined brightness.

In other words, if the white balance is adjusted by adjusting the reference currents for R, G, and B at the predetermined brightness, basically a white balance can be achieved over the entire range of gradations. Thus, the present invention is characterized by comprising adjustment means of adjusting the reference currents for R, G, and B as well as a single-point polygonal or multi-point polygonal gamma curve generator circuit (generating means). The above is a circuit arrangement peculiar to current-controlled EL display panels.

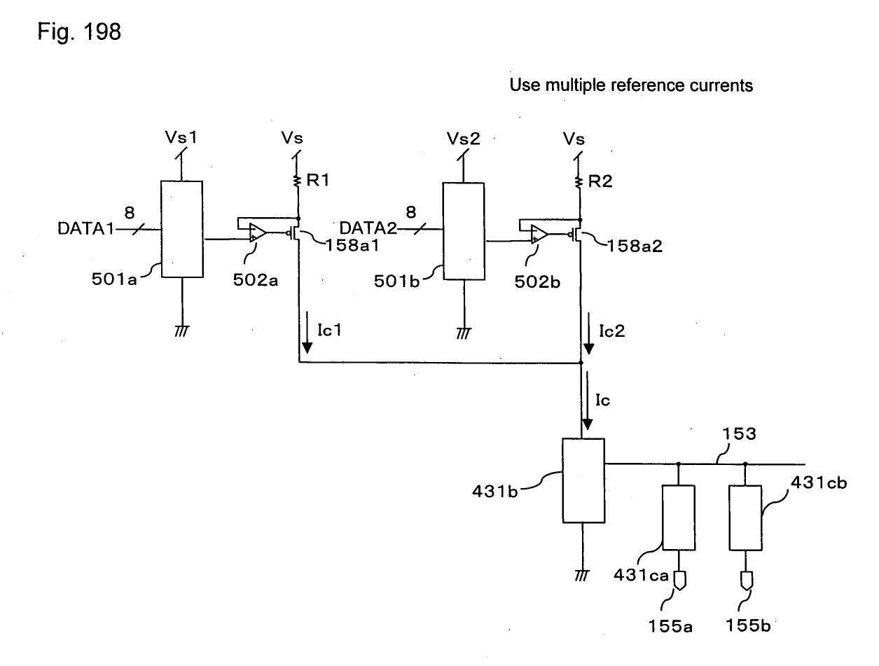

The reference currents can be generated using not only the configurations in FIGS. 60 to 66(a) (b), but also, for example, the configuration in FIG. 198. In FIG. 198, 8-bit data is converted into a voltage by the DA (digital-to-analog) conversion circuit 661. The voltage serves as a power supply voltage (Vs in FIG. 60) for the electronic regulator 501. The electronic regulator 501 is controlled by voltage data (VDATA) and outputs a voltage Vt. The outputted Vt data is inputted in the operational amplifier 502 and a predetermined reference current Ic is outputted by a current circuit consisting of a resistor R1 and transistor 158a. The above configuration makes it possible to expand the variable range of the Vt voltage using 8-bit DATA and 8-bit VDATA.

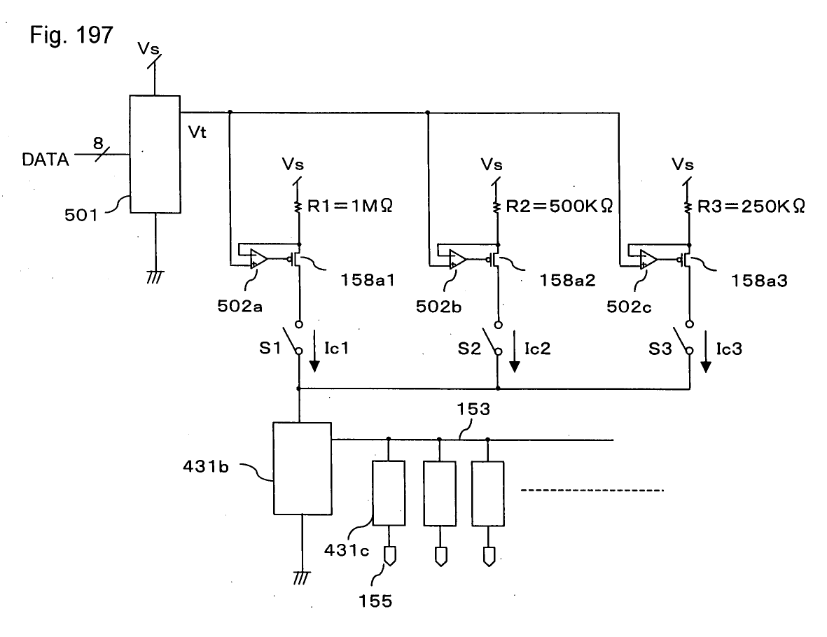

FIG. 197 shows a configuration containing a plurality of current circuits (each comprising of an operational amplifier 502, resistor R* (where*is a resistor number), and transistor 158a). The magnitude of the reference current Ic outputted by each current circuit varies with the resistance. The constant-current circuit comprising an operational amplifier 502a contains a resistor R1 whose resistance is 1 MΩ and passes a reference current Ic1. The constant-current circuit comprising an operational amplifier 502b contains a resistor R2 whose resistance is 500 KΩ and passes a reference current Ic2. The constant-current circuit comprising an operational amplifier 502c contains a resistor R3 whose resistance is 250 KΩ and passes a reference current Ic3.

Switches S are used to select the current circuit whose reference current Ic should be used. The switches S are operated by an input signal from outside. When the switch S1 turns on and switches. S2 and S3 turn off, the reference current Ic1 is applied to a transistor group 431b. When the switch S2 turns on and switches SI and S3 turn off, the reference current Ic2 is applied to a transistor group 431b. Similarly, when the switch S3 turns on and switches S2 and Si turn off, the reference current Ic is applied to a transistor group 431b.

Since the reference currents Ic1, Ic2, and Ic3 differ from each other, the output currents from output terminals 155 can be changed at once by operating the switches S. By operating the switches S periodically such as every field or every frame, it is possible to vary the magnitude of programming current applied to the panel, on a frame-by-frame basis or the like, and thereby average image brightness and the like over multiple fields or frames, resulting in a uniform image display.

Although it has been stated in the above example that the switches S are operated every field or every frame to vary the magnitude of programming current, this is not restrictive. For example, the switches S may be operated every few fields or frames, or every H (horizontal scanning period) or every few Hs (scanning periods). Also, they may be operated randomly so that the predetermined reference current Ic will be applied to the transistor group 431b as a whole.

The drive method which obtains a predetermined reference current as averaged over a certain period by varying the magnitude of programming current periodically or randomly is not limited to the configuration in FIG. 197. For example, the method is also applicable to reference current generator circuits and the like in FIGS. 60 to 66(a)(b), etc. The reference current in each circuit can be varied by operating or varying the electronic regulator 501, power supply voltage Vs, etc.

Although it has been stated in the above example that a reference current Ic selected out of Ic1, Ic2, and Ic3 is applied to the transistors 431b, this is not restrictive. The sum of currents from a plurality of current circuits may be applied to the transistor group 431b. This can be done by turning on a plurality of switches S. The reference current applied to the transistor group 431b can be reduced to 0 A if all the switches S are turned off. If the reference current is 0 A, the programming current outputted from each output terminal 155 is reduced to 0 A. Thus, the output of the source driver IC 14 becomes open. That is, the source driver IC 14 can be cut off from the source signal lines 18.

FIG. 198 shows a configuration in which the sum of reference currents from reference current generator circuits is applied to the transistors 431b. The current circuit comprising the operational amplifier 502a has its output current Ic1 varied by 8-bit data DATA1. The current circuit comprising the operational amplifier 502b has its output current Ic2 varied by 8-bit data DATA2. One or both of the reference currents Ic1 and Ic2 are applied to the transistor group 431b.

FIG. 199 shows another example of the reference current generator circuit. Transistors 158b1 and 158b2 are placed on both sides of gate wiring 153. One or a combination of I, 2I, 4I, and 8I is applied to the transistor 158b1 based on D1 data. That is, a switch S*a (where*is a switch number) is selected based on the D1 data. Incidentally, 2I indicates a current two times larger than I, 4I indicates a current four times larger than I, and so on. One or a combination of I, 2I, 4I, and 8I is applied to the transistor 158b2 based on D1 data. That is, a switch S*b (where*is a switch number) is selected based on the D1 data. The above configuration makes it possible to vary reference currents dynamically.

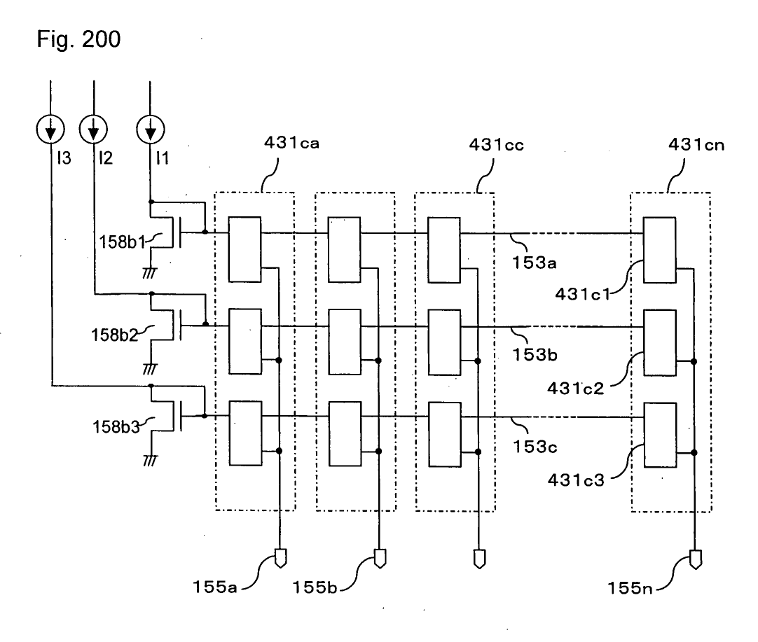

FIG. 200 shows an example in which transistors in transistor groups 431c are divided into multiple blocks (431c1, 431c2, and 431c3). Teaching and learning from the multiple blocks in each transistor group 431c are outputted through the output terminal 155.

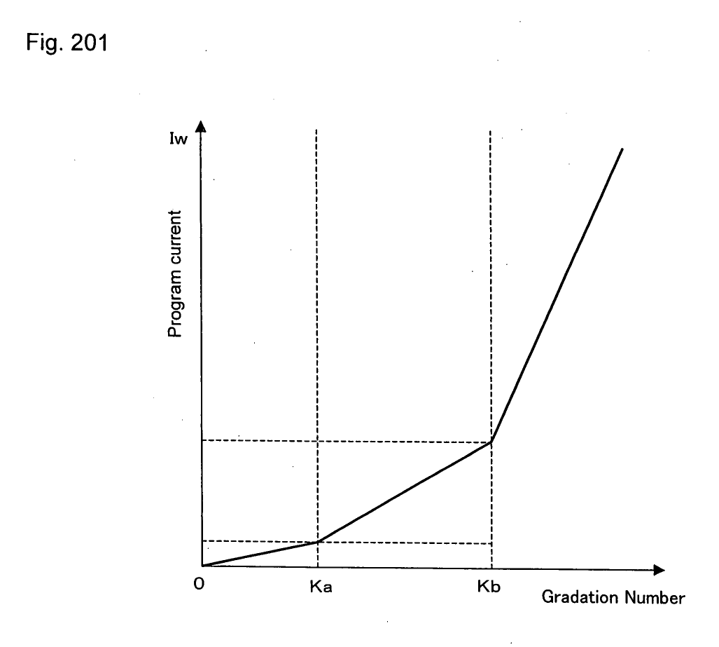

Even if the sizes of unit transistors 154 are the same in the transistor group 431c, if the currents flowing through different unit transistors 154 are different, the programming currents outputted from the output terminal 155 vary in magnitude. As illustrated in FIG. 201, the rate of increase in the programming current with increases in the gradation number is small if the programming current is small (see 0 to Ka in FIG. 201). The rate of increase in the programming current with increases in the gradation number is large if the programming current is small (see Kb or more in FIG. 201). Thus, each transistor group 431c is divided into multiple blocks and the currents supplied to the unit transistors 154 in different blocks are varied in magnitude. Incidentally, this configuration has also been described with reference to FIG. 56.

In FIG. 200, each transistor group 431c is divided into three blocks. The transistors 431c1 in the transistor 431c are set to the potential of the gate wiring 153a based on a reference current I1 applied to the transistor 158b1. The output current of the unit transistors 154 in the transistor group 431c1 is determined based on the potential of the gate wiring 153a. It is assumed here that I1 is smaller than I2 and corresponds to the low gradation range of FIG. 201 (0 to Ka).

The transistors 431c2 in the transistor 431c are set to the potential of the gate wiring 153b based on a reference current I2 applied to the transistor 158b2. The output current of the unit transistors 154 in the transistor group 431c2 is determined based on the potential of the gate wiring 153b. It is assumed here that I2 is smaller than I3 and corresponds to the middle gradation range of FIG. 201 (Ka to Kb). Similarly, the transistors 431c3 in the transistor 431c are set to the potential of the gate wiring 153c based on a reference current I3 applied to the transistor 158b3. The output current of the unit transistors 154 in the transistor group 431c3 is determined based on the potential of the gate wiring 153c. It is assumed here that I3 is the largest and corresponds to the high gradation range of FIG. 201 (Kb or more).

As described above, by dividing each of multiple transistor groups 431c into multiple blocks and varying the magnitudes of reference currents among the resulting blocks, it is possible to easily generate a polygonal gamma curve such as the one shown in FIG. 201. Also, by increasing the number of reference currents, it is possible to obtain a polygonal gamma curve with more points.

Although it has been stated in the above example that each transistor group 431c is divided into multiple blocks and that the unit transistors 154 in the resulting blocks are identical, this is not restrictive. As illustrated in FIG. 55, etc., the unit transistors 154 may vary in size. The transistors do not need to be unit transistors 154 as shown in FIG. 167. Also, the reference currents may be generated using any of the configurations in FIGS. 161 to 168.

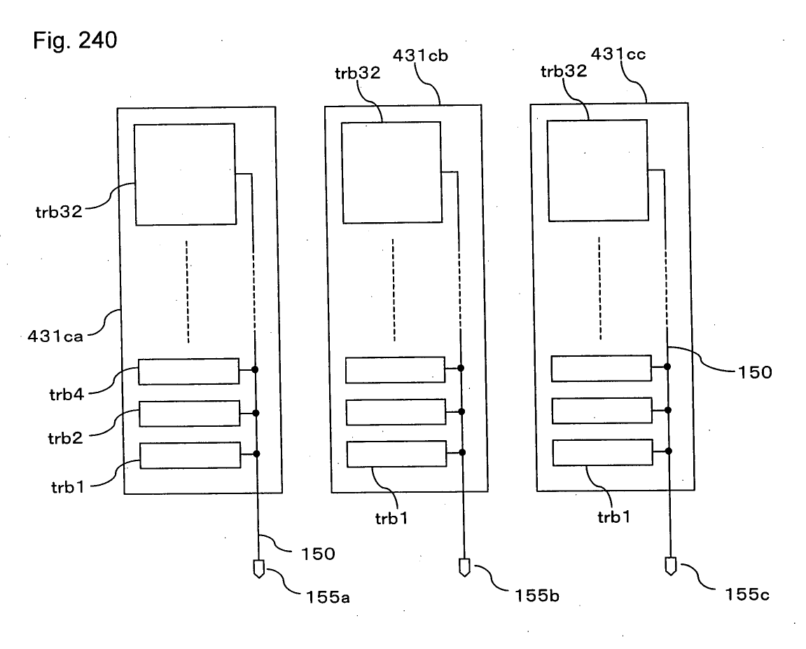

In the above example, basically output stages are constituted of transistor groups 431c as illustrated in FIG. 43. In the transistor groups 431c, the D0 bit is provided by 1 unit transistor 154, the D1 bit is provided by 2 unit transistors 154, the D2 bit is provided by 4 unit transistors 154, . . . , and the Dn bit is provided by the n-th power of 2 unit transistors 154. This configuration is conceptually illustrated in FIG. 240.

In FIG. 240, trb (transistor block) 32 includes 32 unit transistors 154. Similarly, trb (transistor block) 1 includes 1 unit transistor 154 and trb (transistor block) 2 includes 2 unit transistors 154. Trb (transistor block) 4 includes 4 unit transistors 154, and so on.

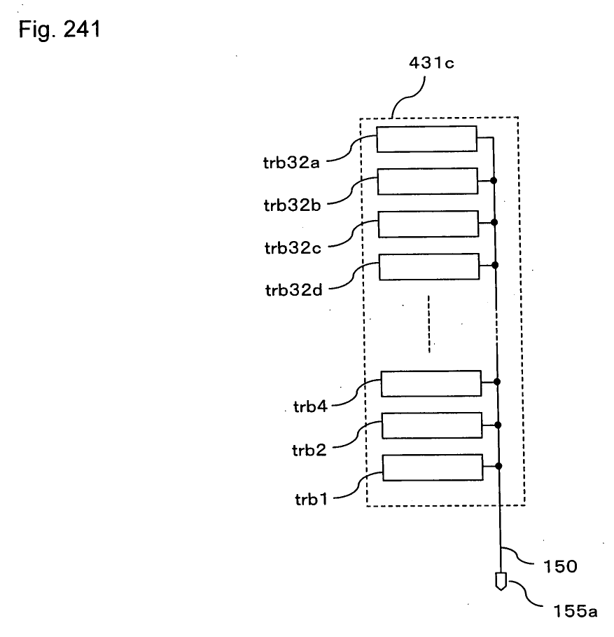

However, the unit transistors 154 vary in characteristics depending on their formation locations in the IC wafer. In particular, periodic characteristic distribution occurs in and around a diffusion structure. For example, characteristics of unit transistors 154 fluctuate at intervals of 3 to 4 mm. Consequently, if transistor groups 431c are formed at the same intervals as terminals 155 as illustrated in FIG. 240, the intensity of the currents outputted from the terminals 155 may fluctuate at intervals (assuming that output gradation is the same at all the terminals 155) To deal with this problem, the present invention further subdivides trb (transistor block) which contains a large number of unit transistors 154 as illustrated in FIG. 241. For example, in FIG. 241, trb32 is divided into four blocks (trb32a, trb32b, trb32c, and trb32d). Basically the number of unit transistors 154 in each resulting block is the same. Needless to say, however, the number of unit transistors 154 may be varied among different blocks.

In FIG. 241, trb32a, trb32b, trb32c, and trb32d consist of eight unit transistors 154 each. Needless to say, trb16 may also be divided into sub-blocks trb16a and trb16b consisting of eight unit transistors 154 each. For ease of explanation, it is assumed here that only trb32 is divided.

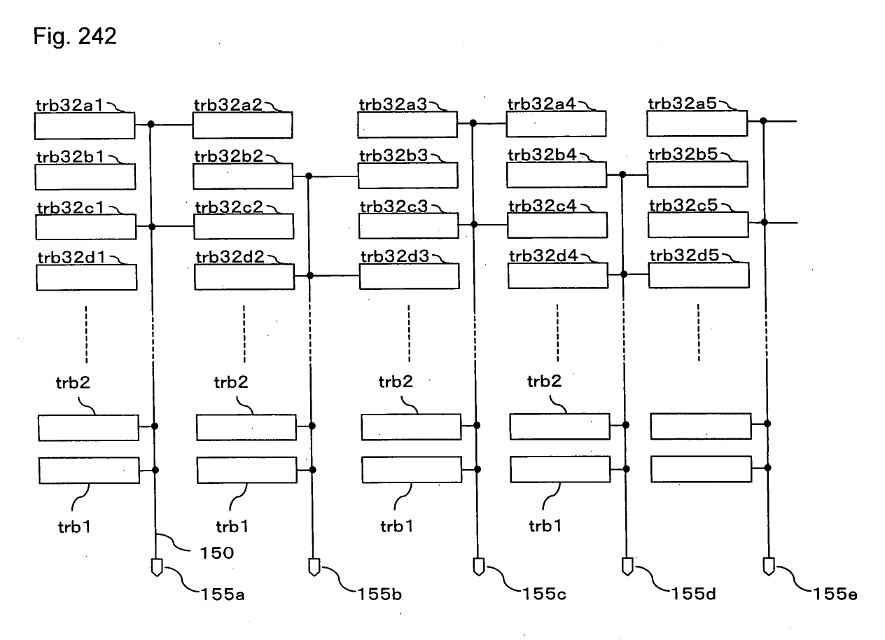

To eliminate periodic fluctuations in output current from output terminals 155, each output stage 431c should be composed of unit transistors 154 located away from each other in the IC (circuit) chip. An example is shown in FIG. 242. However, FIG. 242 is a conceptual illustration. Actually, trb (transistor blocks) located away from each other are connected by lateral wiring to form an output stage 431c for one terminal 155.

In FIG. 242, the D5 bit for the terminal 155a consists of trb32a1, trb32a2, trb32c1, and trb32c2. Thus, the output stage at the terminal 155a includes unit transistor groups which originally belong to the adjacent output terminal 155a. Similarly, the D5 bit for the terminal 155b consists of trb32b2, trb32b3, trb32d2, and trb32d3. Thus, the output stage at the terminal 155c includes unit transistor groups which originally belong to the adjacent output terminal 155b. Furthermore, the D5 bit for the terminal 155c consists of trb32a3, trb32a4, trb32c3, and trb32c4. Thus, the output stage at the terminal 155d includes unit transistor groups which originally belong to the adjacent output terminal 155c, and so on.

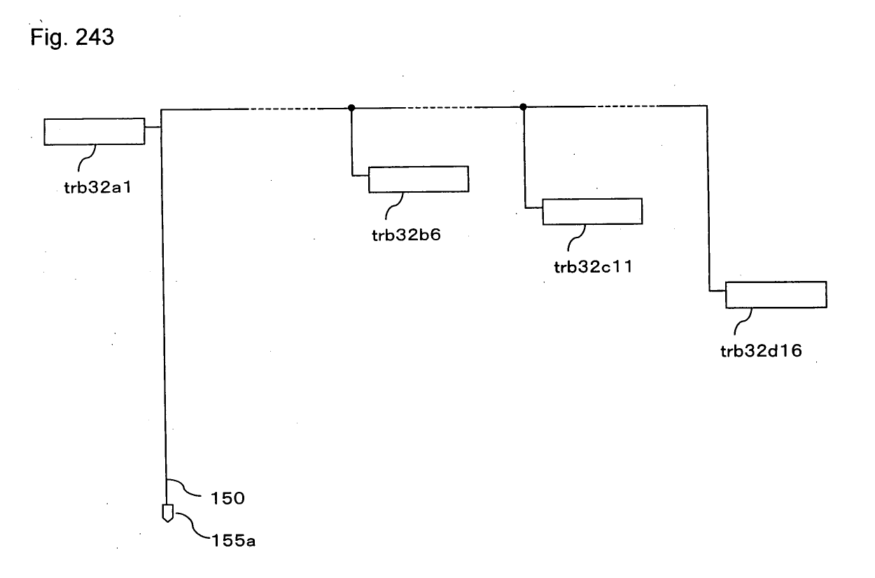

Specifically, transistor subgroups trb are connected as shown in FIG. 243. FIG. 243 shows only connections of trb32 at the terminal 155a (connections for other bits and other terminals 155 are made in a similar manner). In FIG. 243, trb32 consists of trb 32a1, trb32b6 located 6 terminals away, trb32c11 located 11 terminals away, and trb32d16 located 16 terminals away. That is, trb32 is composed (formed) by connecting trb32 which differ in longitudinal and lateral locations. In this way, if each bit in each unit transistor group 431 is provided by unit transistors 154 located away from each other, it is possible to eliminate periodic output variations.

However, if trb (transistor blocks) are connected as shown in FIG. 243, there will be no trb for the terminal 155n (the last terminal). This problem can be solved by using unit transistors 158b (FIGS. 48 and 49) of transistor groups 431b which form current mirrors in conjunction with the transistor groups 431c. The unit transistors 158b are configured to have the same size and shape as the unit transistors 154. The transistor groups 431b are placed on one side or both sides of the IC (circuit) 14. Note that there is obviously no need to use the configuration described below even when forming trb available to the terminal 155n.

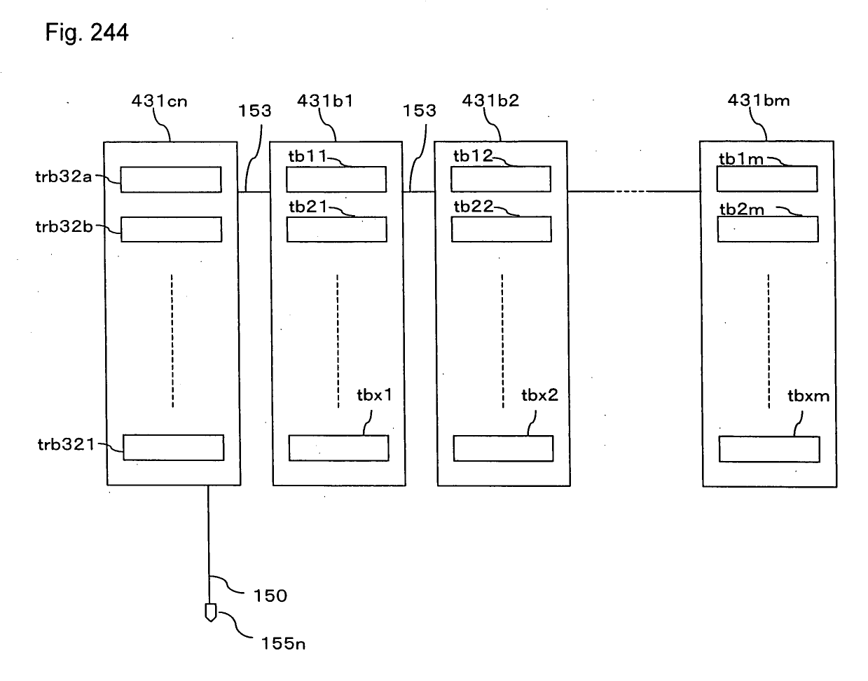

Let tb denote transistor groups which have the same functions as trb (32) composed of unit transistors 158b of the transistor groups 431b (see FIG. 244). Thus, tb and trb are connected to the same gate wiring 153. Therefore, trb32 of the terminal 155n consists of trb 32nl, trb32b6 located 6 terminals away, trb32c11 located 11 terminals away, and trb32d16 located 16 terminals away.

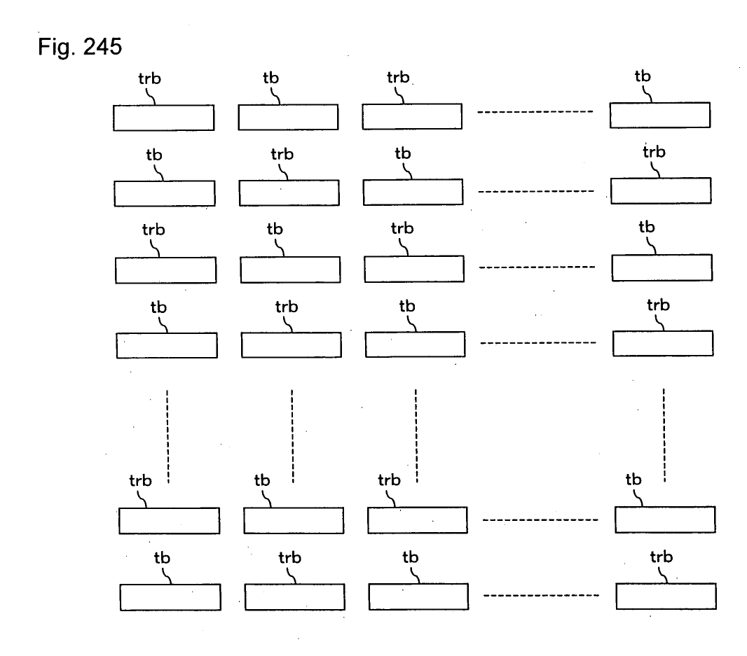

It goes without saying that the need for complicated connections such as those shown in FIG. 244 is eliminated if tb and trb are formed in the IC (circuit) 14 in a distributed manner as illustrated in FIG. 245.

Results of study indicate that preferably the unit transistors 154 are located in an area not smaller than 0.05 square mm. More preferably, the unit transistors 154 are located in an area not smaller than 0.1 square mm. More preferably, the unit transistors 154 are located in an area not smaller than 0.2 square mm. The area (square mm) is calculated from straight lines which link four unit transistors 154 located farthest away.

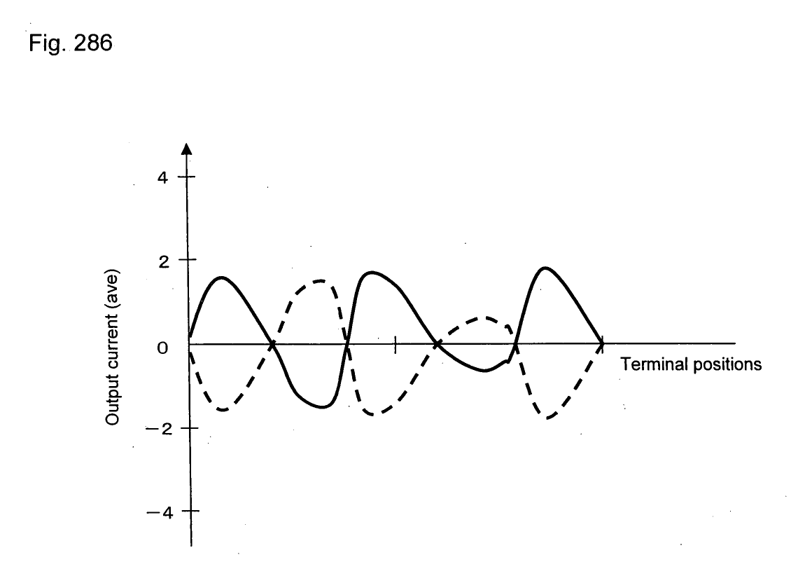

The programming currents outputted to source signal lines 18 often deviate periodically as illustrated in FIG. 286, in which the horizontal axis represents the positions of output terminals in one chip, i.e., the positions of terminals 1 to n. The vertical axis represents the percent deviation from the average value of output programming currents for the 32nd gradation. As illustrated in FIG. 286, output programming currents often deviate periodically due to a diffusion process used in the manufacturing process of ICs.

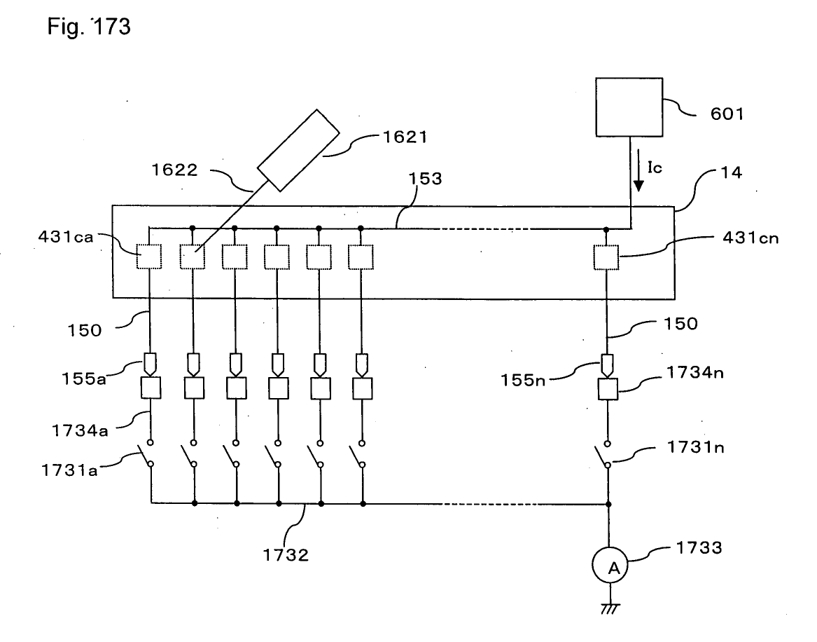

If the output programming current deviates as indicated by the solid line, the deviation can be corrected using a current of opposite phase indicated by the dotted line. The correction (compensation) can be made easily. If the programming current is a sink current, a discharge current within a range of 0 to 5% can be added. Specifically, a discharge current circuit consisting of P-channel unit transistors 154 (see configuration, description, and the like in FIG. 43, etc.) can be formed in the source driver circuit (IC) 14 and the discharge current from this circuit can be added to the programming current outputted from each terminal 155 (thereby correcting the output programming current). Also, the correction may be made by adjusting, configuring, or forming circuit components using the trimming technique and the like described with reference to FIGS. 162 to 176, etc.

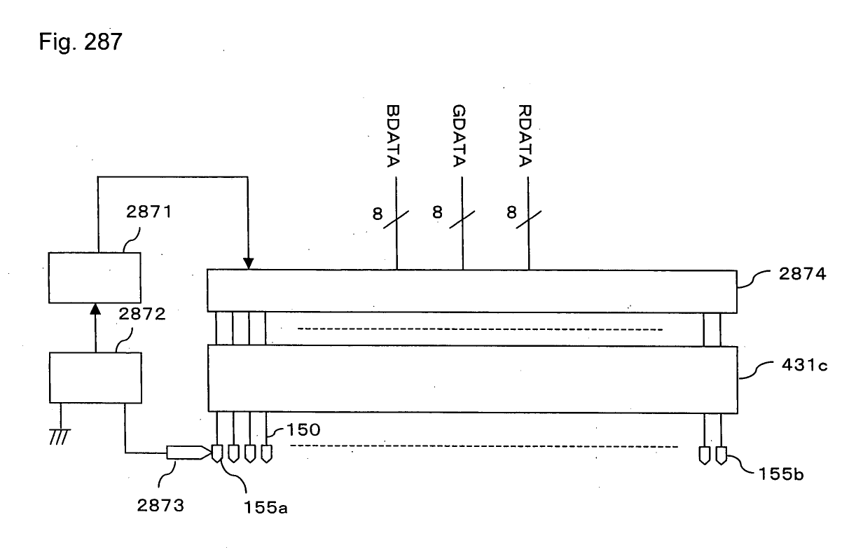

To determine the magnitude of the current to be used for correction (compensation), the programming currents outputted from the terminals 155 are measured as. illustrated in FIG. 287. Video data (RDATA, GDATA, and BDATA) are set to predetermined values (bit values of the unit transistor groups 431c) and programming currents Iw are outputted from the terminals 155. The output currents Iw are measured with a probe 2873 connected to a current measuring circuit 2872 via the terminal 155. Needless to say, switches formed in the source driver circuit (IC) 14 may be used to select the terminal to be connected to the current measuring circuit 2872.

The current measuring circuit 2872 outputs the measured values of the currents to a correction data calculating circuit 2872, which calculates correction data and outputs it to a correction circuit (data conversion circuit) 2874. The correction circuit (data conversion circuit) 2874 consists of a flash memory and the like and adds a discharge current within a range of 0 to 5% to the terminals 155.

However, if output programming currents have periodicity as illustrated in FIG. 286, deviations in the programming currents outputted from all the terminals can be predicted by measuring the programming currents outputted from some of the terminals (in one period or more) instead of measuring the programming currents outputted from all the terminals. Thus, it is sufficient to measure the programming currents outputted from some of the terminals (in one period or more).

An allowable range of variations in the output currents is determined by a pixel pitch P (mm), period (number N of terminals in one period), and rate of brightness change b (%) in the screen 144. For example, even if brightness change between terminals is 5%, naturally tolerance limits are lower when there are 10 terminals between the given terminals than when there are 100 terminals between the given terminals (i.e., 5% will be insufficient).

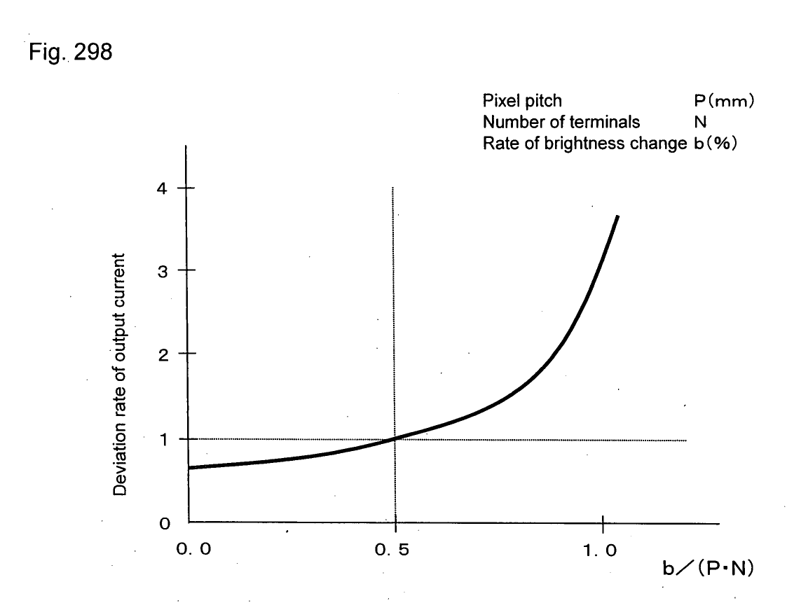

Results of study on the above relationship are shown in FIG. 298. The horizontal axis represents b/(P*N), where P is a pixel pitch (mm) and N is the number of terminals between given terminals of the source driver circuit (IC) 14. Thus, P*N represents the length (distance) of a given period. Thus, b/(P*N) represents the rate of brightness change per (P*N). The vertical axis represents a perceived rate of relative brightness change in the screen 144 (equivalent to a deviation rate of output current because there is a proportional relationship between brightness and programming current) with the value being taken as 1 when b/(P*N) is 0.5. It can be seen that the larger the deviation rate of output current, the tighter the tolerance limits.

As can be seen from FIG. 298, the slope of the curve increases sharply when b/(P*N) is 0.5 or larger. Thus, it is preferable that b/(P*N) is smaller than 0.5.

The rate of brightness change is measured by a luminance meter 3051 as illustrated in FIG. 306. It is controlled by a controller 3053 which controls gradations for the source driver IC 14. A correction to the value measured by the luminance meter 3051 is calculated by a computing unit 3052. The data obtained by the calculation is written into a correction circuit 2874 as illustrated in FIG. 287.

Although output variations of the source driver circuit (IC) 14 has been described in the above example, it is obvious that the technical idea is also applicable to the gate driver circuit (IC) 12. Variations in the turn-on voltage or turn-off voltage can also occur to the gate driver circuit (IC) 12. Thus, a good gate driver circuit (IC) 14 can be constructed or formed if the items described in relation to the source driver circuit (IC) 14 are applied to it. Needless to say, the items described below are also applicable to the gate driver circuit (IC) 12.

The items described in relation to the driver circuits (ICs) according to the present invention are applicable to the gate driver circuit (IC) 12 and source driver circuit (IC) 14. Also, they are applicable not only to organic (inorganic) EL display panels (display apparatus), but also to liquid crystal display panels (display apparatus). Besides, the technical idea of the present invention may be used not only for active-matrix display panels, but also for simple-matrix display panels.

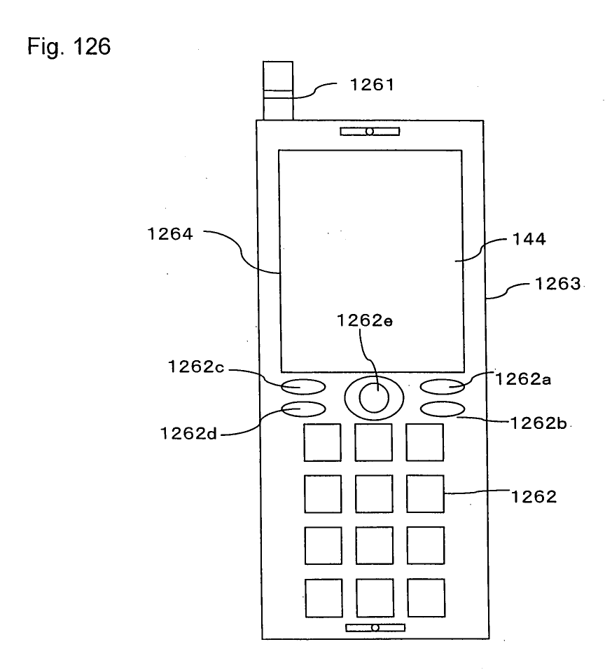

Another example of the source driver circuit (IC) 14 according to the present invention will be described below. Needless to say, the items described above or described herein can be applied to those parts of the source driver circuit (IC) 14 which are not described below. It goes without saying that the items described above and items described below can be used in combination as required. Conversely, it goes without saying that the items described below can be applied to, or used as required in, the other examples of the present invention. Also, it goes without saying that a display panel or display apparatus (FIGS. 126, 154 to 157, etc.) can be constructed using the source driver circuit (IC) 14 described below.

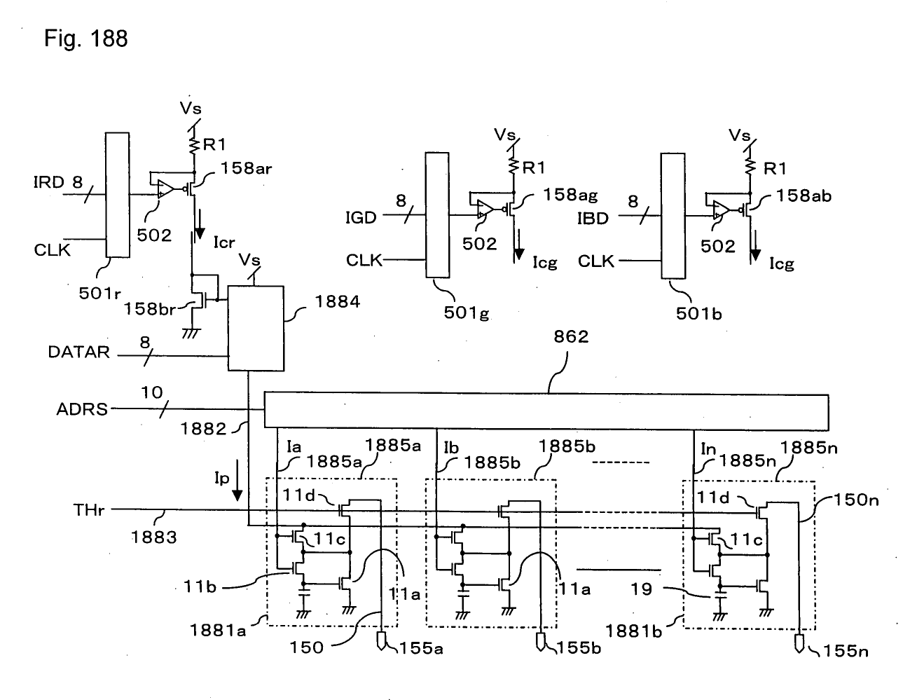

FIG. 188 shows an example of the source driver circuit (IC) 14 according to the present invention. Only those parts which are necessary for description are illustrated. In FIG. 188, the circuit is composed of CMOS transistors made of silicon as is the case with the other examples of the present invention (needless to say, the circuit 14 may be formed directly on an array board 30).

In FIG. 188, control data (IRD, IGD, IBD) which control the electronic regulators 501 have their values established in sync with a clock (CLK) signal. The electronic regulators 501 are controlled based on these values to apply predetermined voltages to the positive terminals of the operational amplifiers 502.

The operational amplifiers 502, resistors R1, and transistors 158a compose constant-current circuits which produce reference currents Ic. Programming currents outputted from the terminals 155 vary in proportion to the magnitudes of the reference currents Ic. A programming current generator circuit 1884 contains a current mirror circuit and DATA decoder. More specifically, the programming current generator circuit 1884 has a configuration typified, for example, by a relationship identical with or similar to the relationship between transistors 158b and transistor groups 431c in FIG. 60 or the relationship between transistors 158b and transistors 154 in FIGS. 209 and 210.

Based on the magnitudes of the reference currents Ic, the programming current generator circuit generates programming currents Ip according to the magnitudes specified by video (image) data, namely, DATA (DATAR, DATAG, and DATAB).

The generated programming currents Ip are held in current-holding circuits 1881, each of which consists of transistors 11a, 11b, 11c and 11d, and a capacitor 19. The current-holding circuit 1881 has a configuration similar to the pixel configuration in FIG. 1, but the P-channel transistors are replaced with N-channel transistors. The programming currents Ip applied to gradation current wiring 1882 are held as voltages in the capacitors 19.

The programming currents Ip are held by a sampling circuit 862 in a dot sequential manner. That is, the sampling circuit 862 selects gradation holding circuits 1881 to hold the programming currents Ip, based on a 10-bits address signal (ADRS) (which allows up to 1024 terminals to be selected). For the selection, a selection voltage (which turns on the transistors 11b and 11c) is outputted to selection signal lines 1885. The programming currents Ip can be held in the gradation holding circuits 1881 randomly. Generally, however, the address signal ADRS is counted in sequence and the current-holding circuits 1881a to 1881n are selected in sequence.

The programming currents Ip are held in the capacitors 19, allowing the driver transistors 11a to output the programming current Ip through the terminals 155. In the current-holding circuits 1881, the driver transistors 11a operate in the same manner as the driver transistor 11a in FIG. 1. The transistors 11b and 11c in FIG. 188 also function or operate in the same manner as the transistors 11b and 11c in FIG. 1. Specifically, a selection voltage is applied to the selection signal lines 1885 in sequence, turning on the transistors 11b and 11c in the current-holding circuits 1881 and thereby causing the programming currents Ip to be held in the transistors 11a (the capacitors 19 connected to the gate terminals of the transistors 11a).

When the programming currents Ip have been written into all the current-holding circuits 1881, a turn-on voltage is applied to an output control terminal 1883 and the programming currents Ip held in the current-holding circuits 1881 are outputted to the terminals 155a to 155n (the programming currents Ip are inputted to the terminals 155 from the source signal lines 18). The timing of the turn-on voltage applied to the output control terminal 1883 is synchronized with. a horizontal scanning clock, i.e., with a pixel row selection (a pixel-row shifting) clock.

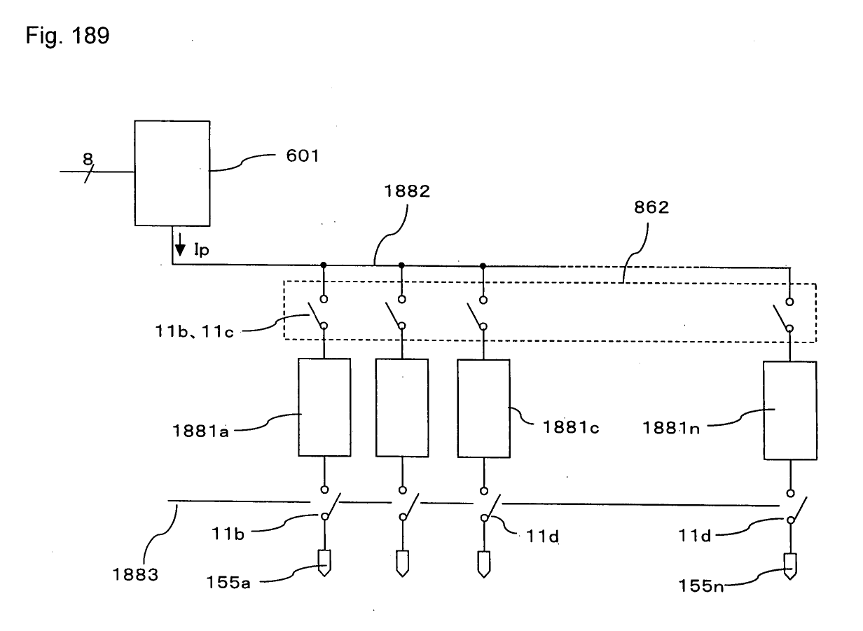

FIG. 189 schematically illustrates the configuration shown in FIG. 188. The programming currents Ip flow through the gradation current wiring 1882 and inputted in the current-holding circuits 1881 as switches 11c and 11b (the transistors 11c and 11b) are controlled by the sampling circuit 862. Also, the switches 11b (transistors 11b) are turned on all together under the control of the output control terminal 1883 to output the programming currents Ip.

Although the current-holding circuits 1881 shown in FIGS. 188 and 189 accommodate only one pixel row, actually current-holding circuits for two pixel rows are required. The current-holding circuits (first holding circuits) for one pixel row are used to output the programming currents Ip to the source signal lines 18 and the other current-holding circuits (second holding circuits) for one pixel row are used to hold the currents sampled by the sampling circuit 862. The first holding circuits and second holding circuits are operated alternately.

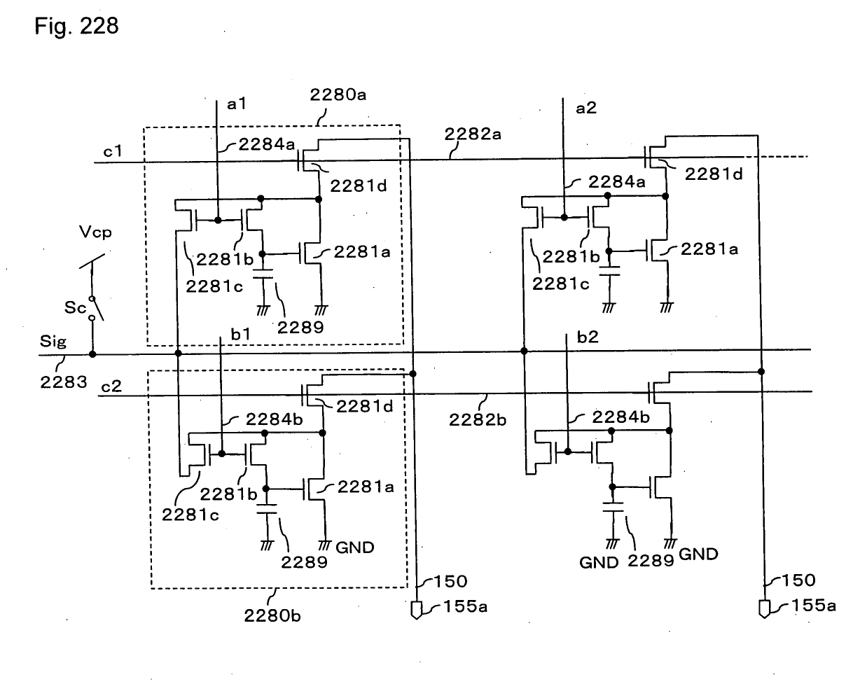

Output stages in FIG. 228 comprise the first holding circuits 2280a and second holding circuits 2280b. When FIG. 188 and FIG. 228 are compared, the current-holding circuits 1881 correspond to output circuits 2280, the gradation current wiring 1882 corresponds to a current signal line 2283, the output control terminal 1883 corresponds to gate signal lines 2282, the selection signal lines 1885 correspond to gate signal lines 2284, the transistors 11a correspond to transistors 2281a, the transistors 11b correspond to transistors 2281b, the transistors 11c correspond to transistors 2281c, the transistors 11d correspond to transistors 2281d, and the capacitors 19 correspond to capacitors 2289.

When programming currents Ip are being sampled and inputted to the output circuit 2280a, the output circuit 2280b is outputting programming currents Ip held by the source signal line 18. Conversely, when the output circuit 2280a is outputting programming currents Ip held by the source signal line 18, the output circuit 2280b is holding sampled programming currents Ip in sequence. The output circuit 2280a and output circuit 2280b take turns to output (input) programming currents Ip to the source signal line 18b every 1 H. This switching is done through c1 and c2 terminals.

A switch Sc for use to apply a reset voltage Vcp is formed or placed on the current signal line 2283. When the switch Sc is turned on, the reset voltage Vcp is applied to the current signal line 2283. The reset voltage Vcp has a value close to the GND voltage. When applying the reset voltage, a turn-on voltage is applied to the gate signal lines 2284, thereby turning on the transistors 2281b and 2281c. When the transistors 228b and 2281c turn on, the capacitors 2289 are discharged, keeping the transistors 2281a from outputting current.

That is, the reset voltage Vcp brings the transistors 2281a to or close to an OFF state. Needless to say, the reset voltage Vcp may be configured to make the transistors 2281a output an intermediate-level voltage.

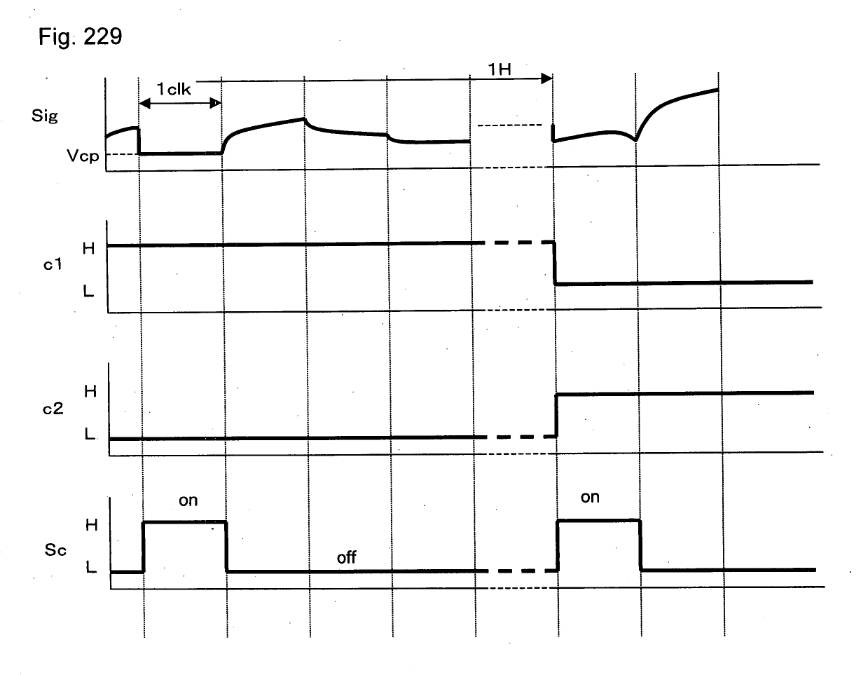

FIG. 229 is a timing chart of the circuit shown in FIG. 228. In FIG. 229, Sig indicates a signal from the programming current generator circuit 1884. A current corresponding to a video signal is applied continuously. Sc indicates operation of the reset switch. In high (H) state, in which switch Sc is on, a reset voltage Vcp is applied to the current wiring 2283. As can be seen from FIG. 229, the reset voltage Vcp is applied at the beginning of 1 H.

After the reset voltage Vcp is applied to the current-holding circuit (output circuit) 2280a or 2280b, the programming current Ip is sampled and held in the output circuit 2280. The application of the reset voltage Vcp is not limited to once in 1 H. The reset voltage Vcp may be applied per sampling in one output circuit 2280 or per sampling in a plurality of output circuits 2280. Alternatively, it may be applied once in every frame or once in multiple frames.

Reference characters c1 and c2 denote switching signals. When the c1 logic voltage is high (H), the output circuit 2280a is selected. When the c2 logic voltage is high (H), the output circuit 2280b is selected and the programming current Ip is outputted to the source signal line 18.

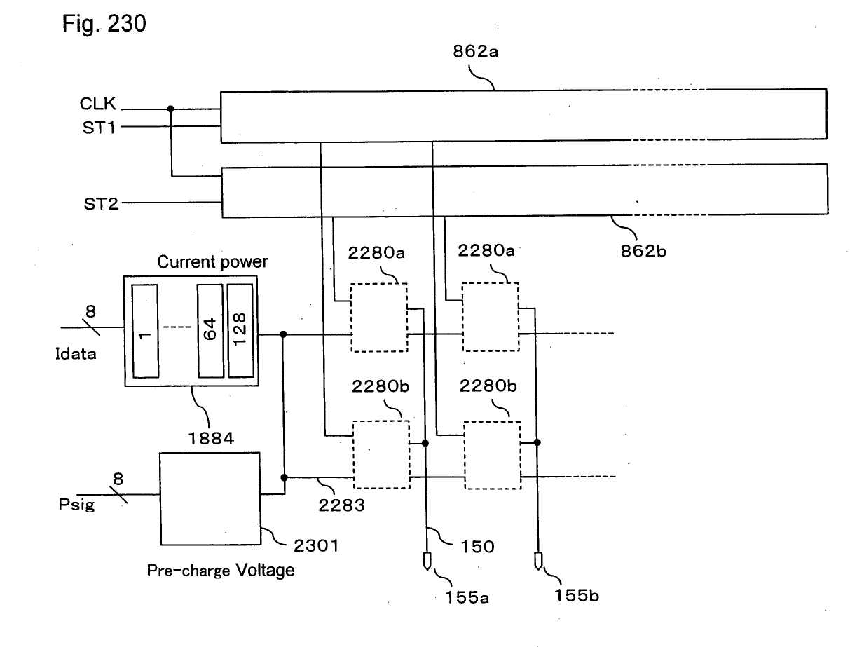

To apply (hold) the programming current Ip in sequence by selecting the output circuit 2280a or 2280b in this way, it is well to provide two sampling circuits 862 as illustrated in FIG. 230. The sampling circuit 862a selects the output circuits 2280a in sequence and makes the output circuits 2280a hold the programming current Ip. The sampling circuit 862b selects the output circuits 2280b in sequence and makes the output circuits 2280b hold the programming current Ip.

The reset voltage Vcp may be configured to vary the precharge voltage as illustrated in FIG. 75. Incidentally, the items described in relation to the precharge voltage are also applicable to the reset voltage Vcp. This can be achieved by replacing the precharge circuit in FIG. 75 with a reset circuit 2301 in FIG. 230. Similarly, a reference current circuit 1884 can have the configuration described above.

A problem with the output circuits 2280 is that a signal applied to the gate signal lines 2284 may change the gate terminal potential of the holding transistors 2281a, causing changes to the programming current Ip which is held. This is because signal waveforms applied to the gate signal lines 2284 penetrate due to parasitic capacitance, changing the gate terminal potential. The penetration voltage reduces the programming current Ip which is held if the holding transistors 2281a are N-channel transistors. In the configuration in FIG. 228, if the holding transistors 2281a are P-channel transistors, the programming current Ip which is held is increased.

A configuration which solves this problem is illustrated in FIG. 231. In the output circuit 2280 in FIG. 231, a transistor 2311 is formed or placed between a switching transistor 2281b and capacitor 2289. The transistor 3211 has a function to open wiring.

The transistor 2311 operates (turns off) before the sampled programming current Ip is held in the output circuit 2280 and a turn-off voltage is applied to the gate signal line 2284 (the output circuit 2280 is cut off from the current signal line 2283). That is, a turn-off voltage is applied to the gate signal line 2284 first, and then a turn-off voltage is applied to the gate signal line 2284 with some delay. Consequently, the transistor 2311 is turned off, and then the output circuit 2280 is cut off from the current signal line 2283.

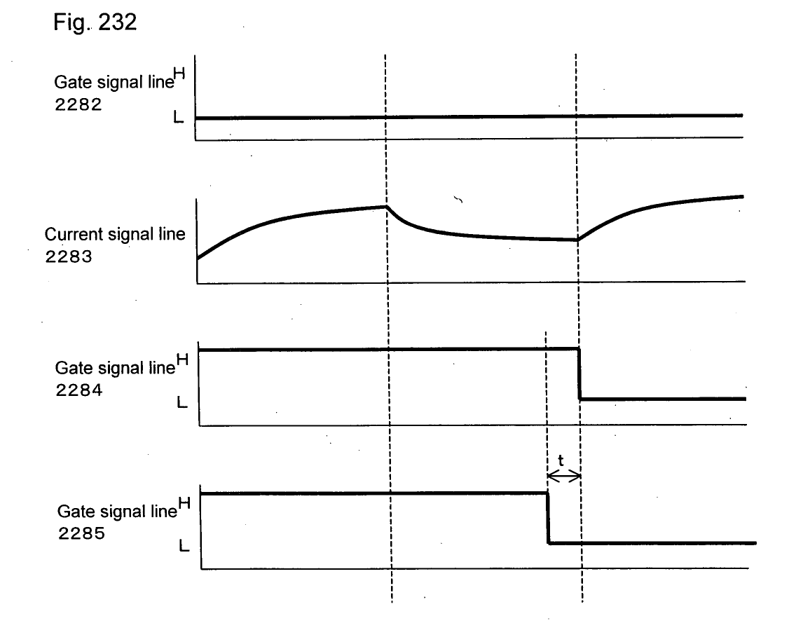

FIG. 232 is a timing chart of the gate signal lines 2284, 2285, etc. As can be seen from FIG. 232, a turn-off voltage is applied to the gate signal line 2285 first, and then a turn-off voltage is applied to the gate signal line 2284.

First the transistor 2311 is turned off as described above. By turning off the transistor 2311, it is possible to reduce the penetration voltage in the gate signal line 2284. Preferably, time t in FIG. 232 is 0.5 μsec or longer. Preferably, it is 1 μsec or longer.

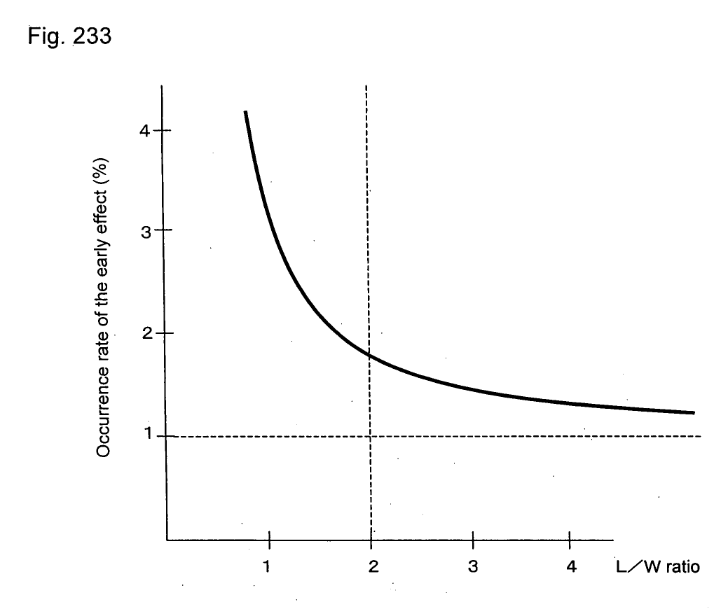

Preferably, the holding transistor 2281a has a certain WL ratio to prevent or reduce kinking (Early effect). FIG. 233 shows a graph of the occurrence rate of the Early effect. As illustrated in FIG. 233, the Early effect has a large impact when the L/W ratio is 2 or less. Conversely, when L/W (the ratio of the channel length (μm) to the channel width (μm) of the transistor 2281a) is larger than 2, the Early effect decreases sharply. Thus, it is preferable that the L/W ratio of the transistor 2281a is 2 or higher. More preferably, it is 4 or higher.

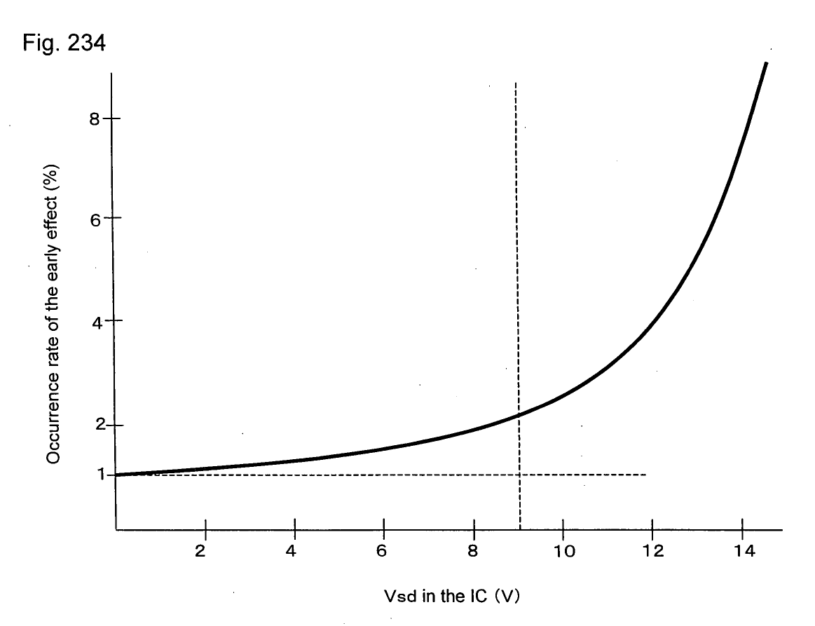

Also, there is a relationship between channel-to-channel voltage (source-to-drain voltage Vsd in the IC) of the holding transistor 2281a and Early effect. The relationship is illustrated in FIG. 234. Incidentally, the Vsd voltage is the maximum voltage applied to the holding transistor 2281a. It is a voltage applied to the terminal 155 in FIG. 231, etc.

As can be seen from the graph in FIG. 234, the Early effect tends to have a marked impact when the Vsd voltage is 9 V or below. Thus, it is preferable that the voltage applied to the terminal 155, i.e., the voltage applied to the source signal line 18 is between 9 and 0 V (GND) (both inclusive). More preferably, the voltage applied to the source signal line 18 is between 8 and 0 V (both inclusive).

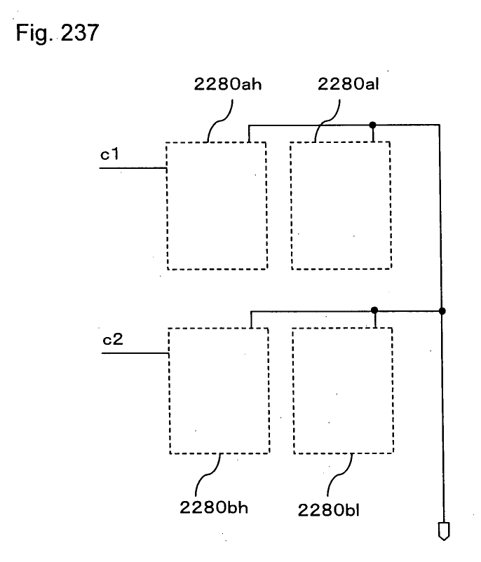

In the above example, two stages of output circuits 2280 are provided. However, the present invention is not limited to this, and more than two stages may be provided as illustrated in FIG. 237. In FIG. 237, output circuit 2280a is divided into two output circuits: an output circuit 2280ah and output circuit 2280al. Similarly, the output circuit 2280b is divided into an output circuit 2280bh and output circuit 2280bl. The output circuit 2280ah and output circuit 2280bh output relatively large programming current Iph while the output circuit 2280al and output circuit 2280bl output relatively small programming current Ipl.

Above like, by dividing the output circuits 2280a and 2280b into a plurality of output circuits, it is possible to separate or add gradations allotted to different output circuits 2281 before outputting them. This makes it possible to output accurate programming currents Ip.

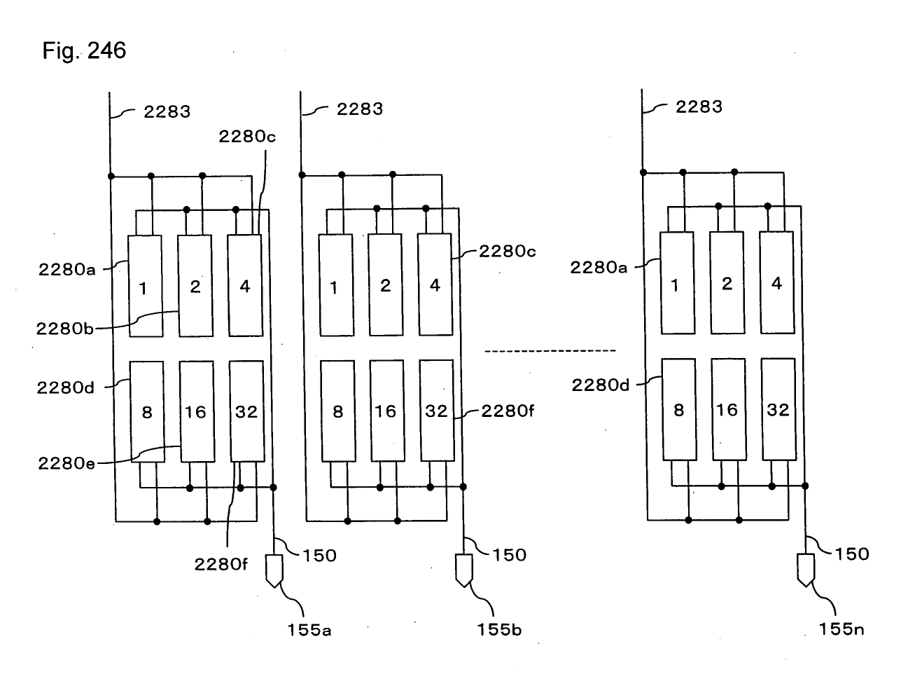

The output stages of the source driver circuit (IC) 14 according to the present invention may be configured as shown in FIG. 246. Each output stage in FIG. 246 consists of an output stage circuit 2280a which outputs a current of magnitude 1, an output stage circuit 2280b which outputs a current of magnitude 2, an output stage circuit 2280c which outputs a current of magnitude 4, an output stage circuit 2280d which outputs a current of magnitude 8, an output stage circuit 2280e which outputs a current of magnitude 16, and an output stage circuit 2280f which outputs a current of magnitude 32. The output stage circuits 2280a to 2280f operate in accordance with respective bits of video data. The currents thus produced from the output stage circuits 2280a to 2280f are added and outputted through the terminal 155. The configuration in FIG. 246 makes it possible to produce accurate current outputs.

In the above example, the source driver circuit (IC) 14 consists mainly of a silicon chip. However, the present invention is not limited to this. The output stage circuits 2280 (polysilicon current-holding circuits 2471) and the like may be formed or constructed directly on the array board 30 using polysilicon technology (such as CGS technology, low-temperature polysilicon technology, or high-temperature polysilicon technology).

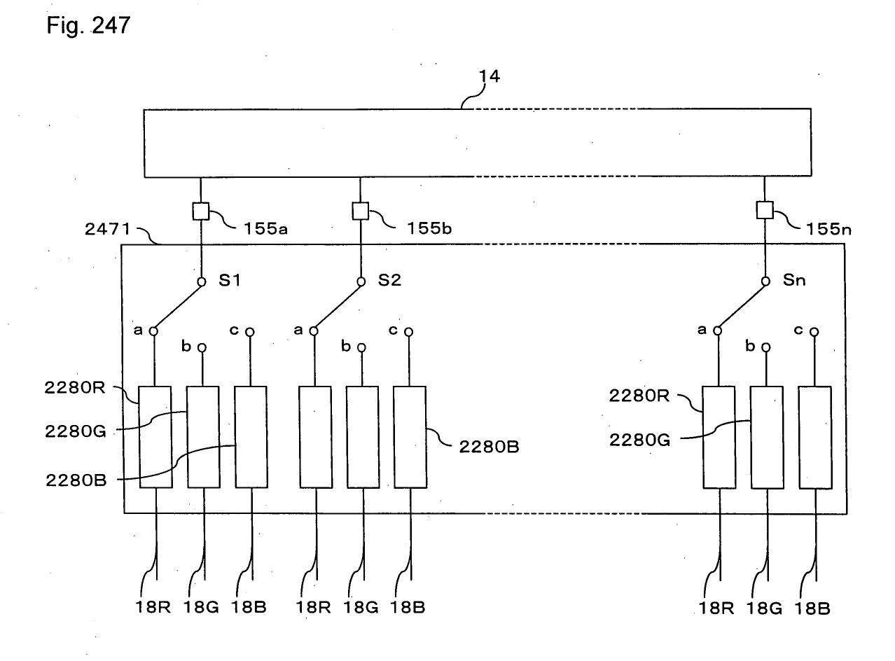

FIG. 247 shows an example. R, G, and B output stage circuits 2280 (2280R for R, 2280G for G, and 2280B for B) and switches S for selecting among them are formed (constructed) by polysilicon technology. The switches S operate by time-sharing a 1H period. Basically, the switches S are connected to the R output stage circuits 2280R, the G output stage circuits 2280G, and the B output stage circuits 2280B for ⅓ the 1H period each. The display or drive method has been described with reference to FIGS. 37 and 38, and thus description thereof will be omitted.

As illustrated in FIG. 247, the source driver circuit (IC) 14 equipped with shift register circuits, sampling circuits, etc. is connected to the source signal lines 18 through the terminals 155. The switches S made of polysilicon are connected to the output stage circuits 2280R, 2280G, and 2280B on a time-shared basis. The output stage circuits 2280R, 2280G, and 2280B hold currents constituted of RGB video data. They output programming currents Iw to the source signal lines 18R, 18G, and 18B using the configuration and method described with reference to FIGS. 228 to 234, etc. Although only one stage of polysilicon current-holding circuits 2471 are illustrated in FIG. 247, it goes without saying that there are actually two stages (see the description of FIGS. 228 to 234).

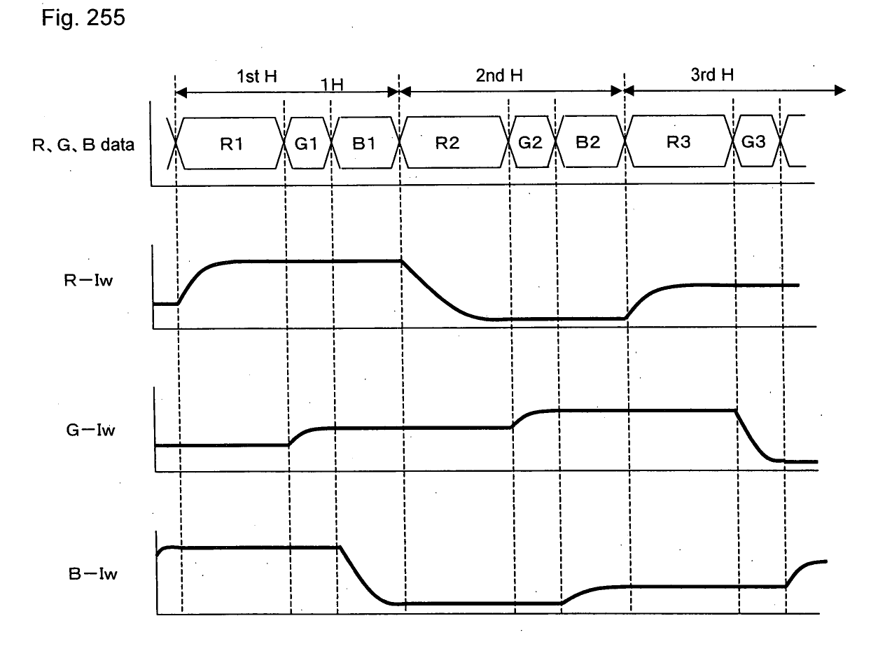

Although it has been stated with reference to FIG. 247 that the switches S are connected to the R output stage circuits 2280R, the G output stage circuits 2280G, and the B output stage circuits 2280B for ⅓ the 1 H period each, the present invention is not limited to this. For example, selection periods may vary among R, G, and B as illustrated in FIG. 255. This is because the magnitudes of programming currents Iw vary among R, G, and B due to differences in the efficiency of EL elements 15 among R, G, and B. A programming current small in magnitude is susceptible to parasitic capacitance of the source signal lines 18, so its application duration should be increased to secure time to charge and discharge the parasitic capacitance of the source signal lines 18. On the other hand, the magnitude of the parasitic capacitance in the source signal lines 18 is often the same for R, G, and B.

In FIG. 255, it is assumed that the red (R) EL elements 15 give high efficiency and the smallest programming current. Also, it is assumed that the green (G) EL elements 15 give low efficiency and the largest programming current. The blue (B) EL elements 15 give efficiency intermediate between R and G. Thus, during a 1H period in FIG. 255, the selection period for R data (the period for which 2280R is selected in FIG. 247) is the longest, the selection period for G data (the period for which 2280G is selected in FIG. 247) is the shortest, the selection period for B data (the period for which 2280B is selected in FIG. 247) is intermediate between the two.

Preferably, the mobility of the holding transistor 2281a is between 400 and 100 (both inclusive). More preferably, the mobility is between 300 and 150 (both inclusive). To satisfy this condition, the gate insulating film of the transistor 2281a is made thicker. Possible methods for this include, for example, double-layer deposition and the like which give a multilayer structure to the gate insulating film.

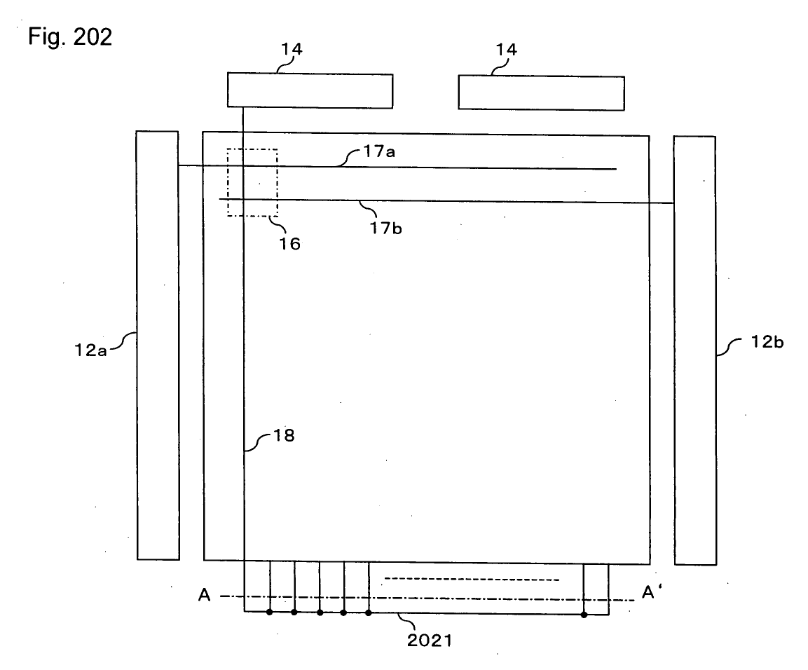

A checking method of the display panel according to the present invention will be described below. FIG. 202 shows the display panel according to the present invention before completion. The source signal lines 18 are short-circuited at one end by a short-circuiting wire 2021. After the checkup, the short-circuited segments are cut off along A-A′ line to complete the display panel. By applying a probe and a checking voltage to the short-circuiting wire 2021, it is possible to apply the checking voltage to all the source signal lines 18.

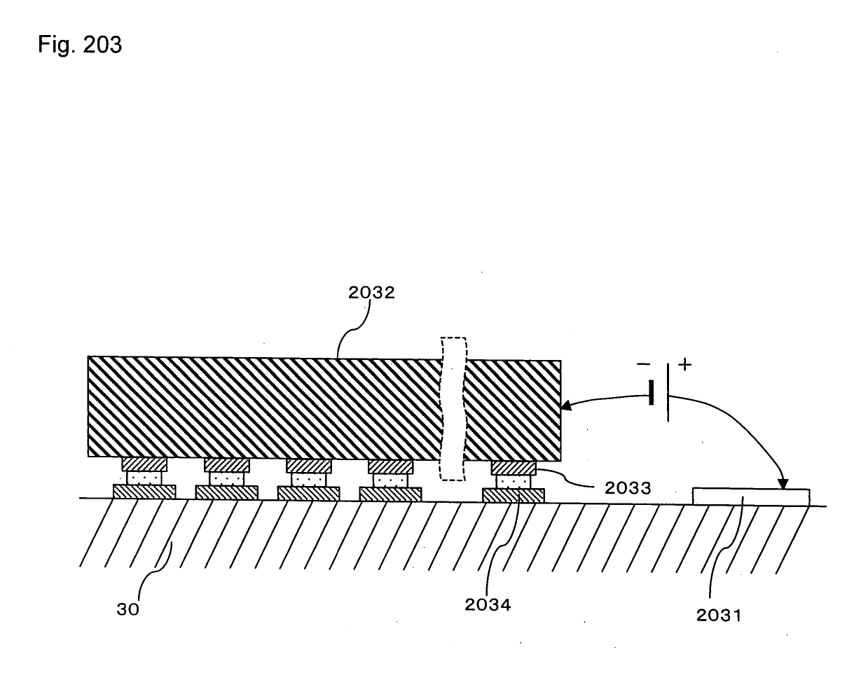

If no short-circuiting wire 2021 is provided, voltage or current is applied through COG terminals of the source signal lines 18. FIG. 203 shows an example in which a short-circuiting pad 2032 for checking is mounted on COG terminals (source signal line terminals) 2034. The short-circuiting pad 2032 is made of metal or conductive material. The short-circuiting pad may be insulating material such as a glass substrate on which aluminum is vapor-deposited. The short-circuiting pad may be of any type as long as it can short-circuit the terminals 2034. The short-circuiting pad is configured to apply an electrical signal such as a voltage to the source signal line terminals 2034.

An AC or DC voltage (current) is applied to the short-circuiting pad 2032 and an anode terminal wire 2031 as illustrated in FIG. 203. The short-circuiting pad 2032 is connected to the source signal lines 18 via terminals 2033. Thus, voltages can be applied to the source signal lines 18 and anode of the pixels 16. For example, voltages can be applied to the Vdd terminal and source signal line 18 in FIG. 1. In this state, the gate drivers 12 are operated by applying a power supply voltage, clocks, etc. (see FIG. 14, etc.) The pixels 16 are selected in sequence on a row-by-row basis and voltages are applied to the gate terminals of the driver transistors 11a via the source signal lines 18. By the application of voltages to the gate terminals, currents flow from the driver transistors 11a to the source signal lines 18. That is, currents flow through the EL elements 15, causing the EL elements 15 to emit light.

The above procedures make it possible to scan and operate the gate driver circuits 12, causing the EL elements 15 to emit light in sequence, optically detect blinking or continuous light emission, and thereby check the EL display panel.

The checking is performed optically, meaning that judgments/detection are made based on, for example, human vision, image recognition of images taken by a CCD camera, or intensity measurement of electrical signals by a photosensor. Conditions which can be detected include constantly bright pixels, constantly black pixels, line defects, and flicker defects as well as streaks and density irregularities. Also, flickering can be detected.

Although short-circuiting pad 203 is illustrated in FIG. 203, conductive liquid or the like may be dropped on the source signal lines 2034. An AC or DC voltage (current) is applied between the dropped liquid or the like and anode terminal wire 2031. In the case of current programming, the current applied is very weak—on the order of microamperes. Thus, even if the conductive liquid or the like has high resistance, it is sufficient for the purpose of checking. Conductive liquids or gels available for use include, for example, sodium hydroxide, hydrochloric acid, nitric acid, sodium chloride solution, silver paste, copper paste, etc.

In the above example, the panel or array is checked with the gate driver circuits 12 put in scanning mode and the EL elements 15 illuminated on a row-by-row basis. However, the present invention is not limited to this. For example, checking may be performed with the entire display screen illuminated at once.

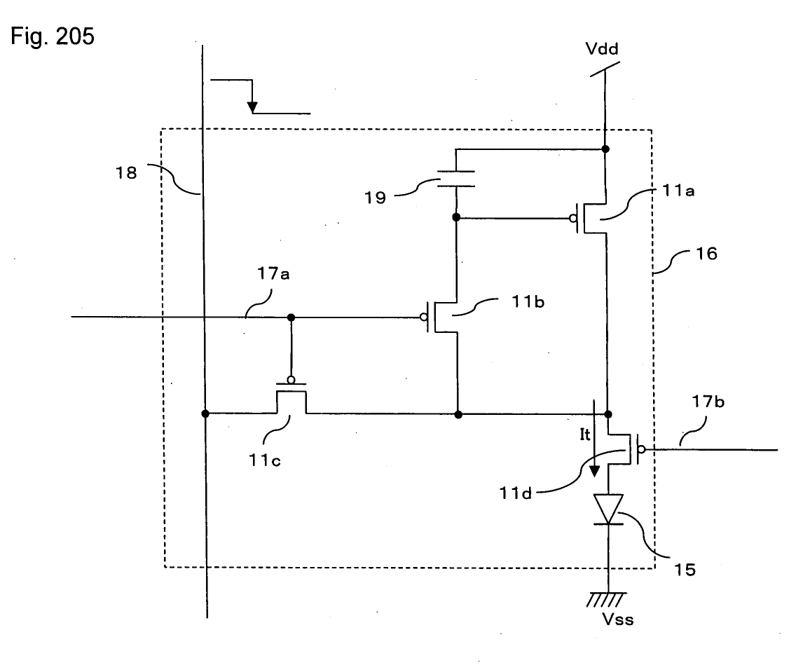

FIG. 205 is an explanatory diagram illustrating all-at-once checking of a screen.

Although it is stated for ease of explanation that the entire display screen is checked at once, this is not restrictive. Checking may be performed by dividing the screen into blocks or illuminating multiple pixel rows at a time in sequence. That is, checking may be performed by illuminating a large number of pixels at once. Needless to say, checking may be performed by illuminating pixels one by one.

For ease of explanation, it is assumed that voltage sufficient to illuminate the EL elements 15 can be supplied if the anode voltage Vdd is set to 6 V and the driver transistors 11a are set to 5 V or less. Also, it is assumed that voltage is applied to all the source signal lines 17 externally. In this way, the checking method according to the present invention ensures that a voltage equal to or lower than the rising voltage of the driver transistors 11a can be applied to the source signal lines 18 if the driver transistors 11a of the pixels 16 are P-channel transistors. For ease of explanation, it is assumed that the rising voltage is 5 V. The voltage applied to the source signal lines is in a range from the anode voltage Vdd to the anode voltage Vdd minus 8 V. Preferably, it is in a range from the anode voltage Vdd to the anode voltage Vdd minus 6 V.

In FIG. 205, it is assumed that a checking voltage of 0 to 5 V is applied to the source signal lines 18. As the voltage is applied to the gate terminals of the driver transistors 11a, the driver transistors 11a can pass current.

The checking method changes the voltage applied to the gate signal lines 17a from turn-off voltage (Vgh) to turn-on voltage (Vgl) with a turn-off voltage Vgh applied to all the gate signal lines 17b, and thereby writes the potential of the source signal lines 18 into the pixels 16. If the potential of the source signal lines 18 is not higher than the rising voltage (5 V) of the driver transistors 11a, the driver transistors 11a are programmed to pass a voltage.

Then, a turn-on voltage Vgl is applied to all the gate signal lines 17b. Either simultaneously with that or earlier than that, the voltage applied to the gate signal lines 17a is changed from turn-on voltage (Vgh) to turn-off voltage (Vgl). Consequently, if the driver transistors 11a and the like are normal, current is supplied from the driver transistors 11a to the EL elements 15, illuminating the EL elements 15.

When the EL elements 15 are illuminated, if a turn-on voltage and turn-off voltage are applied to the gate signal lines 17b alternately, the EL elements 15 blink. This makes it possible to determine whether or not the switching transistors 11d are good.

Incidentally, in FIG. 205, with a turn-on voltage applied to both gate signal lines 17a and 17b, the voltage applied to the source signal lines 18 may be changed periodically between a higher voltage and lower voltage than the rising voltage of the driver transistors 11a. The periodic change will cause the EL elements 15 to emit light accordingly. In that case, the light-emitting current It of the EL elements 15 is supplied from the source signal lines 18. In some cases, it is supplied from the driver transistors 11a.

The above operation makes it possible to detect performance and defects of the driver transistors 11a as well as switching transistors 11c, 11b, and 11d. Also, performance and characteristics of the driver transistors 11a and EL elements 15 can be assessed.

The above example involves varying the potential of the source signal lines 18 to control light emission according to the potential of the source signal lines 18. However, the present invention is not limited to this. For example, the anode voltage Vdd may be varied as illustrated in FIG. 206.

Such a checking method changes the voltage applied to the gate signal lines 17a from turn-off voltage (Vgh) to turn-on voltage (Vgl) with a turn-off voltage Vgh applied to all the gate signal lines 17b, and thereby writes the potential of the source signal lines 18 into the pixels 16. If the potential of the source signal lines 18 is not higher than the rising voltage (5 V) of the driver transistors 11a, the driver transistors 11a are programmed to pass a voltage.

Then, a turn-on voltage Vgl is applied to all the gate signal lines 17b. Either simultaneously with that or earlier than that, the voltage applied to the gate signal lines 17a is changed from turn-on voltage (Vgh) to turn-off voltage (Vgl). Consequently, if the driver transistors 11a and the like are normal, current is supplied from the driver transistors 11a to the EL elements 15, illuminating the EL elements 15. When the EL elements 15 are illuminated, if a turn-on voltage and turn-off voltage are applied to the gate signal lines 17b alternately, the EL elements 15 blink. This makes it possible to determine whether or not the switching transistors 11d are good.

With a turn-off voltage applied to the gate signal lines 17a and a turn-on voltage applied to the gate signal lines 17b, the voltage Vdd applied to the anode terminal is changed periodically in a range below the rising voltage of the driver transistors 11a. The periodic change will cause the EL elements 15 to emit light accordingly. Incidentally, the light-emitting current It of the EL elements 15 is supplied from the driver transistors 11a. The above operation makes it possible to detect performance and defects of the driver transistors 11a as well as switching transistors 11c, 11b, and 11d. Also, performance and characteristics of the driver transistors 11a and EL elements 15 can be assessed.

Although the above example has been described in relation to the pixel configuration in FIG. 1, this is not restrictive. Needless to say, it is also applicable to EL display panels or EL display apparatus with any of the configurations in FIGS. 2, 7, 11, 12, 13, 28, 31, 607, etc.

Although the above example has been described in relation to current programming, the present invention is not limited to this. Checking can be performed in the case of voltage programming in FIG. 2 and the like as well.

FIG. 207 is an explanatory diagram illustrating a voltage-programming pixel configuration. The checking method changes the voltage applied to all the gate signal lines 17a from turn-off voltage (Vgh) to turn-on voltage (Vgl), and thereby writes the potential of the source signal lines 18 into the pixels 16. If the potential of the source signal lines 18 is not higher than the rising voltage (5 V) of the driver transistors 11a, the driver transistors 11a are programmed to pass a voltage.

Then, the voltage applied to the gate signal lines 17a is changed from turn-on voltage (Vgh) to turn-off voltage (Vgl). Consequently, if the driver transistors 11a and the like are normal, current It is supplied from the driver transistors 11a to the EL elements 15, illuminating the EL elements 15.

With a turn-off voltage applied to the gate signal lines 17a, the voltage Vdd applied to the anode terminal is changed periodically in a range below the rising voltage of the driver transistors 11a. The periodic change will cause the EL elements 15 to emit light accordingly. Incidentally, the light-emitting current It of the EL elements 15 is supplied from the driver transistors 11a. The above operation makes it possible to detect performance and defects of the driver transistors 11a as well as switching transistors 11c. Also, performance and characteristics of the driver transistors 11a and EL elements 15 can be assessed.

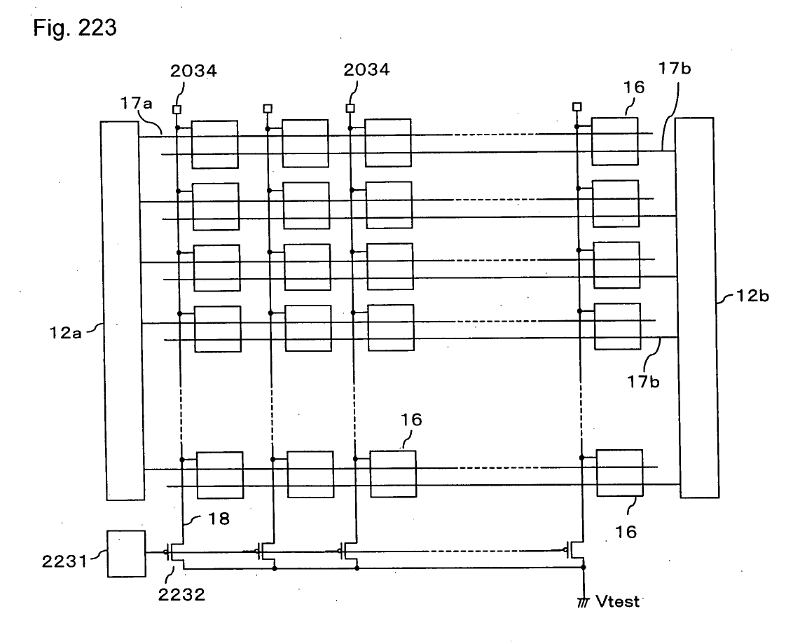

A checking method according to another example of the present invention will be described with reference to drawings. Whereas according to the method in FIG. 202, the short-circuiting wire 2021 is cut off after checking, in the configuration in FIG. 223, a transistor 2232 is formed or placed as a test switch at one end of each source signal line 18. As a voltage is applied to the gate terminal of the transistor 2232, the transistor 2232 is turned on, causing a test voltage (Vtest) to be applied to the source signal line 18. The transistor 2232 is turned on and off by on/off control means 2231.

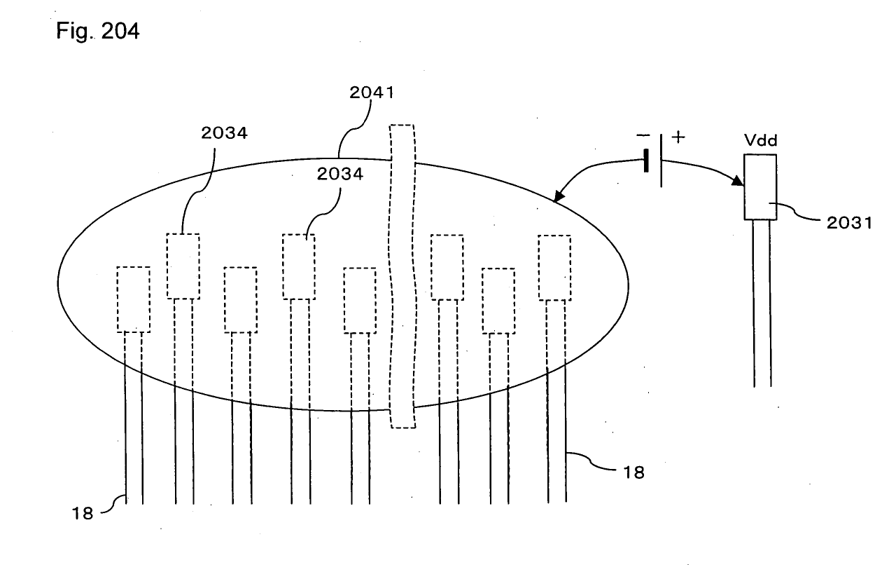

The on/off control means 2231 turns on and off the transistor 2232 in sync with the gate driver circuits 12. Specifically, the checking method described with reference to FIGS. 203 to 207 is used.

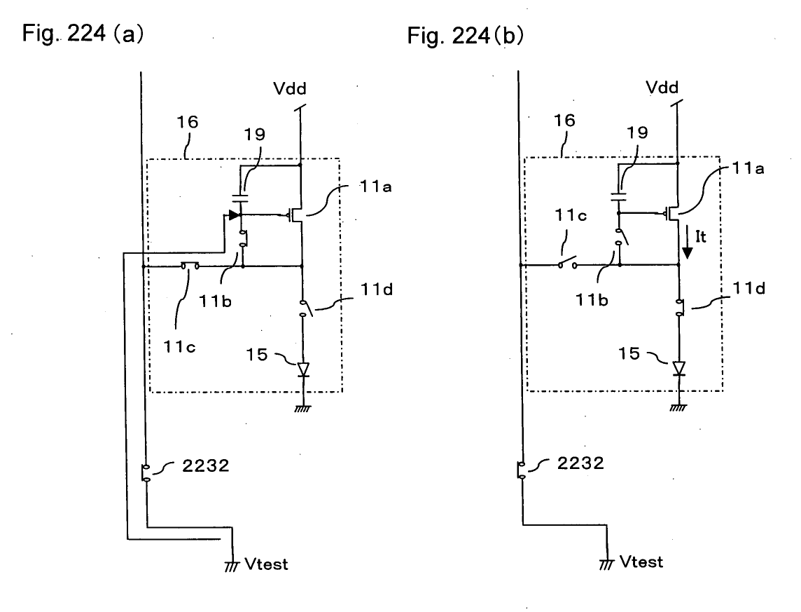

Checking is performed, for example, as illustrated in FIG. 224. As the transistor 2232 turns on, the Vtest voltage is applied to the source signal line 18 via the transistor 2232 as illustrated in FIG. 224(a). At this time, the transistor 11d is open with a turn-off voltage applied to the gate signal line 17b. If a turn-on voltage is applied to the gate signal line 17a of the pixel 16 to be checked, the Vtest voltage is applied to the gate terminal of the driver transistor 11a as illustrated in FIG. 224. The Vtest voltage is higher than the rising voltage of the driver transistor 11a.

Then, a turn-off voltage is applied to the gate signal lines 17a and a turn-on voltage is applied to the gate signal lines 17b as illustrated in FIG. 224(b). Consequently, a light-emitting current It flows from the driver transistor 11a to the EL element 15, causing the EL element 15 to emit light.

In the configuration in FIG. 223, even if a turn-on voltage is applied to the gate signal lines 17a of all the pixels 16, the EL elements 15 can be blinked by turning on and off the transistors 2232 by the on/off control means 2231. That is, characteristics and the like of the EL elements 15, etc. can be assessed or checked using the transistors 2232.

The method in FIG. 223 applies currents or voltages to the source signal lines 18 by controlling the transistors 2232 and thereby checks or assesses the EL display panel or the array for the EL display panel.

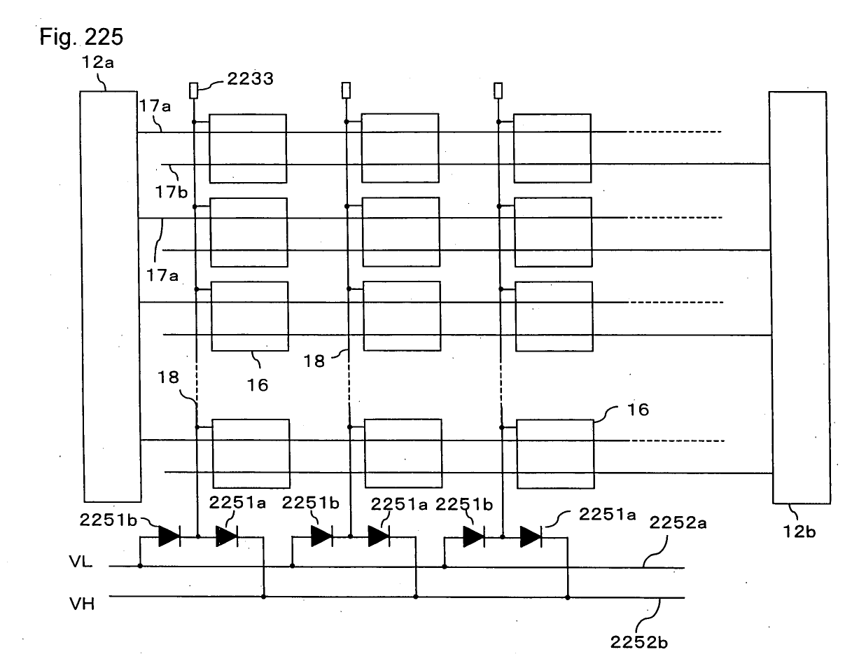

In FIG. 225, voltages or currents needed for checking are applied to the source signal lines 18 using protective diodes 2251 formed on the source signal lines 18. Protective diodes 2251 are formed on each source signal line 18 for electrostatic protection by polysilicon technology. The protective diodes 2251 are composed of diode-connected transistors (see also FIG. 436).

As illustrated in FIG. 225, each source signal line 18 is connected with protective diodes 2251a and 2251b. The protective diodes are designed to be off in normal voltage settings (VL or VH). That is, the protective diodes 2251 are kept off by the application of reverse voltage in the form of VL or VH.

For checking, one or both of the VL voltage and VH voltage are set (or manipulated) so as to turn on the protective diodes 2251. For example, if the VL voltage is set high, the checking voltage (the high voltage: Vdd to Vdd−6 V) can be applied to the source signal lines 18 from the voltage wiring 2252a via the protective diodes 2251b. Also, if the VH voltage is set low, the checking voltage Vk (the low voltage) can be applied to the source signal lines 18 from the voltage wiring 2252b via the protective diodes 2251a.

As illustrated in FIG. 436, the checking voltage Vk is applied to each source signal line 18 via the protective diode 2251. The checking voltage Vk saturates the driver transistor 11a. If the driver transistor 11a is a P-channel transistor and the anode voltage Vdd is 6 V, preferably the checking voltage Vk is between 0 and 2 V (both inclusive). Alternatively, it is preferable that the checking voltage Vk is between Vdd−6 and Vdd−4 (V) (both inclusive). Incidentally, 0 V is the minimum voltage of the video signal, i.e., the lowest voltage outputted by the source driver IC 14. Thus, the minimum voltage is not limited to 0 V. If the driver transistor 11a is a P-channel transistor, the minimum voltage corresponds to the voltage outputted by the source driver circuit IC 14 to the source signal lines 18 to obtain a white raster, i.e., the maximum brightness.

Also, it is preferable that the checking voltage Vk is equal to or less than Vdd−Vdd/(1.5×L/W) and equal to or more than 0 (V) (the voltage outputted to the source signal lines 18 by the source driver circuit (IC) 14 to obtain a white raster, i.e., the maximum brightness, when the driver transistor 11a is a P-channel transistor), where W (μm) is the channel width and L (μm) is the channel length of the driver transistor 11a (if each pixel 16 contains n driver transistors 11a connected in parallel, W×n is used; and if each pixel 16 contains n driver transistors 11a connected in series, L×n is used). Furthermore, it is preferable that the checking voltage Vk is between Vdd−Vdd/(2×L/W) or less, and 0 V is the voltage outputted to the source signal lines 18 by the source driver circuit (IC) 14 to obtain a white raster, i.e., the maximum brightness, when the driver transistor 11a is a P-channel transistor.

When the driver transistor 11a is an N-channel transistor, a saturation voltage is applied to the N-channel transistor. That is, since the procedures for P-channel transistors can be used similarly, description will be omitted. Although it has been stated in the example in FIG. 436, etc. that voltage is applied to each source signal line 18 via the protective diode 2251, this is not restrictive. Needless to say, the voltage may be applied by another method. It goes without saying that current or voltage may be applied to the source signal line 18, for example, via a transistor or by pressing a probe against the source signal line 18.

As illustrated in FIG. 436, etc., by applying voltage to the source signal lines 18 and thereby passing current through the driver transistors 11a, it is possible to illuminate the EL elements 15 of pixels 14 on the screen 144. Thus, the illumination of the EL display panel can be assessed easily. Also, since the driver transistors 11a are saturated if a current larger than a certain level is passed through the EL elements 15, irregularities in laser shots cause little irregularities in the characteristics of the driver transistors 11a. Therefore, display can be checked properly.

However, if the driver transistors 11a are illuminate in a saturated state, a large current flows through the EL elements 15. This may generate heat in the EL display panel, degrading the EL display panel in the checking process. To solve this problem, the present invention uses the duty ratio control illustrated in FIG. 429 (see also FIGS. 19 to 27, 54, etc.).

If the proportion of the illuminated area 193 is increased as illustrated in FIG. 439(a), the brightness of the screen 144 is increased, making it easier to perform checking. However, increases in the proportion of the illuminated area 193 increases heat generation in the panel as well. If the proportion of the illuminated area 193 is decreased as illustrated in FIG. 439(b), the brightness of the screen 144 is decreased, making it hard to perform checking. The amount of heat generated in the panel can be reduced. Duty ratio control can be performed easily by controlling the gate driver circuit 12b and the like as illustrated in FIGS. 19 to 27, 54, etc. The checking methods according to the present invention are characterized by performing duty ratio control by controlling the gate driver circuits 12.

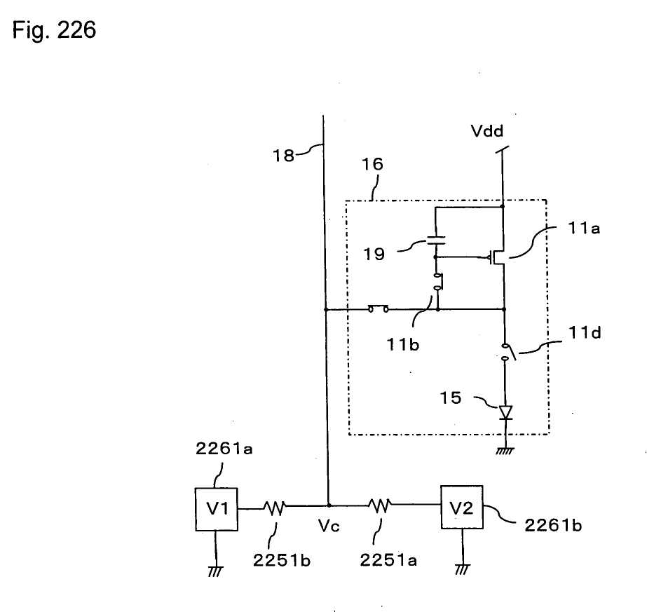

FIG. 226 is an explanatory diagram illustrating conditions during checking. The protective diodes 2251 can be regarded as resistors when they are leaky. The capability of the present invention to check an EL display panel or an array by putting diodes in a leaky state and applying checking voltage to source signal lines owes greatly to current programming of the pixels 16. In the case of current programming, the current used for programming is very weak—on the order of microamperes. Thus, even if the protective diode 2251 is leaky or otherwise has high resistance, application or discharge of the minute current is not affected.

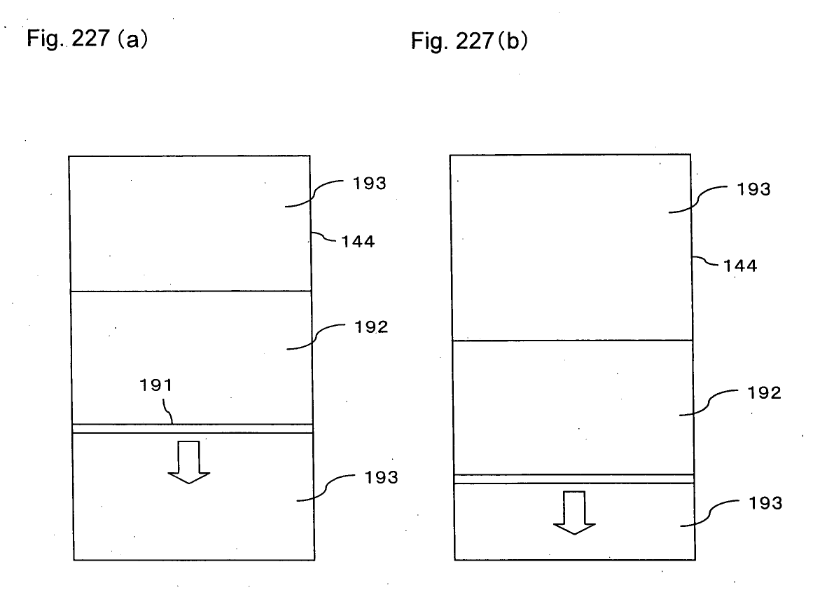

Checking may be performed either by illuminating all the pixels 16 in the display area 144 simultaneously or by selecting and scanning pixel rows in sequence as illustrated in FIGS. 227(a) and 227(b). Reference numeral 191 in FIGS. 227(a) and 227(b) denotes the pixel row into which a checking current is written. Reference numeral 193 denotes an area in which checking is performed optically by illuminating the EL elements 15. Reference numeral 192 denotes a non-illuminated area.

Thus, by providing the illuminated area 193 and non-illuminated area simultaneously in the display area 144, it becomes easy to perform optical checks because defects in black display and white display can be checked either simultaneously or sequentially (in scanning mode) This can be done easily by controlling the gate driver circuits 12 as described with reference to FIG. 14, etc. The scanning or selection method has been described earlier, and thus description thereof will be omitted.

Checking can be performed by setting the potential of voltage wiring 2252 such that the protective diodes 2251 will turn on or get leaky and applying a current or voltage to the source signal lines 18 from the voltage wiring 2252. The checking method has been described earlier, and thus description thereof will be omitted.

The present invention provides a checking method of an array or display panel which has a current-programming pixel configuration or the like. The method causes the protective diodes 2251 to leak to the source signal lines 18, writes the leakage current into pixels, and makes the EL elements emit light using the written current. It detects characteristics or defects of the EL elements 15 by making the EL elements 15 emit light, illuminate, or blink. At the same time, it performs checking by applying a signal to the gate driver circuits 12 and thereby making them scan gate signal lines 17 which are shifted or constantly selected. In this way, defects of transistors 11 in pixels 16 are detected, etc.

In the case of current programming, the currents applied to the source signal lines 18 are on the order of microamperes. Consequently, the currents applied via the protective diodes 2251 are sufficient to program the pixels 16. Thus, checking can be performed. On the other hand, in the case of voltage programming, which involves writing voltage data into the source signal lines 18, it is difficult to perform checking.

Although it has been stated with reference to FIG. 225 that the protective diodes 2251 are formed, etc., this is not restrictive. Needless to say, switching elements, relay circuits, etc. may be formed or placed as shown in FIG. 223.

The checking method in FIGS. 225 and 223 involves applying currents or voltages externally. However, the present invention is not limited to this. For example, with the pixel configuration in FIG. 1, by turning on the switching transistors 11b and 11c (with the transistor 11d kept off (open)), the current flowing from the anode Vdd to the transistor 11acan be drawn out of the array (display panel) via the source signal line 18. By measuring or assessing the magnitude and flow direction of the current, it is possible to check or assess the array and the like. Similarly, the current flowing via the cathode Vss and EL element 15 can be drawn out via the source signal line 18. Thus, the EL element 15 and the like can be checked similarly.

Although it has been stated with reference to FIGS. 223 and 225 that a predetermined voltage is applied to all the source signal lines 18 all at once, this is not restrictive. A current may be applied instead of the voltage. For example, a low current or constant current is applied to the voltage wiring 2252 in FIG. 225. By scanning the gate driver circuits 12 using this current as a programming current, it is possible to program the pixels 16 with current.

It is alternatively possible to provide a plurality of on/off control means, use one of them to apply voltage or current to the odd-numbered source signal lines 18, and use the other on/off control means to apply voltage or current to the even-numbered source signal lines 18. Besides, the transistors 2232 may be replaced with external elements such as relays or elements such as photodiodes which can perform on/off control by light irradiation.

Although it has been stated in the above example that voltage or current needed for checking are applied to the source signal lines 18 from outside, the present invention is not limited to this. Means of generating checking voltage may be incorporated into the array board 30 or the like using polysilicon technology. Also, a method which involves absorbing current (sink type) may be used instead of the method which involves applying current. Besides, the current passed by the EL elements 15 or driver transistors 11a may be detected or measured via the source signal lines 18.

FIG. 437 is an explanatory diagram illustrating a method of checking pixels 16 for defects on an array. As illustrated in FIG. 437(a), a voltage Vc is applied to the source signal line 18 (see also FIG. 226). Then, a turn-on voltage is applied to the gate signal line 17a1 and gate signal line 17a2. The application of the turn-on voltage causes the switching transistors 11b and 11c to turn on. The switching transistors 11b and 11c cause the voltage Vc applied to the source signal line 18 to be applied to the gate terminal of the driver transistor 11a. The applied voltage Vc is held in the capacitor 19.

Then, as illustrated in FIG. 437(b), the checking voltage Vc is removed and an ammeter (current detection means or current measuring means) 4371 is connected to the source signal line 18 (the ammeter 4371 may be kept connected when the checking voltage Vc is applied).

Then, a turn-off voltage is applied to the gate signal line 17a2 and a turn-on voltage is applied to the gate signal line 17a1 (the turn-on voltage remains applied). Consequently, the drain terminal and gate terminal of the driver transistor 11a are disconnected, causing the voltage held in the capacitor 19 to be saved during checking. Thus, the driver transistor 11a can pass an output current resulting from the applied voltage (current).

Since a turn-on voltage is applied to the gate signal line 17a1, a current path which connects the drain terminal of the driver transistor 11a with the source signal line 18 is maintained. With the checking method in FIG. 437, the anode voltage Vdd is applied to one terminal of the driver transistor 11a. Thus, current flows along the following path: the anode Vdd→the source terminal of the driver transistor 11a→the drain terminal of the driver transistor 11a→the switching transistor 11c→the source signal line 18.

The current flowing through the driver transistor 11a is measured by the ammeter (current detection means or current measuring means) 4371 connected to the source signal line 18 (the ammeter 4371 may be kept connected when the checking voltage Vc is applied). If the magnitude of the current (or voltage) detected by the ammeter 4371 matches expectations, the pixel 16 is normal. If it does not match expectations, it is likely that the pixel 16 is defective. In this way, the pixel can be checked.

The above operation is performed on pixel rows in sequence from the top edge to the bottom edge of the screen. Of course, it is not strictly necessary to select pixel rows in sequence. Checks or assessments may be performed by selecting pixel rows randomly. Also, checks may be performed by selecting odd-numbered pixel rows in sequence in the first field, and even-numbered pixel rows in sequence in the second field.

The checking method according to the present invention configures the pixel 16 such that the transistors 11c and 11b can be turned on and off separately and controls the voltage or current applied via the source signal line 18 so as to operate (or not to operate, according to another method) the driver transistor 11a of the pixel 16. Then, the transistor 11b is opened to allow the driver transistor 11a to operate for a certain period. Also, the transistor 11c is turned on to form a current path.

FIG. 437 shows an example which uses the same source signal line 18 to apply the pixel 16 voltage and detect output voltage. FIG. 438 shows a configuration which employs different source signal lines 18. In FIG. 438, a transistor 11e is placed between the transistor 11d and EL element 15. One end of the transistor 11e is connected to the source signal line 18b.

A checking voltage Vc2 or checking current is applied to the source signal line 18b. The checking voltage or the like is outputted to the source signal line 18a via the transistor 11e, transistor 11d, and transistor 11c. Thus, with the pixel configuration in FIG. 438, the transistor 11d can be checked for defects.

In the example of the present invention, pixel (row) selection time may be varied during checking. By increasing the selection time, it is possible to increase checking accuracy. Also, the pixel selection time may be decreased during general checking of the EL display panel, and increased during detailed checking.

The checking method according to the present invention is not limited to checks on a row-by-row basis or pixel-by-pixel basis. For example, multiple pixel rows or multiple pixels may be checked simultaneously. It is alternatively possible to short-circuit multiple source signal lines 18 and connect a current system 4731 to each short circuit. In that case, the ammeters 4371 detect currents from multiple pixels 16. Defects of pixels 16 and the like may be detected based on the magnitudes of the detected currents or presence or absence of currents. Also, after selecting multiple pixel rows and checking them generally, if they are found to be neither normal nor abnormal, they may be checked in detail on a row-by-row basis.

FIG. 441 shows an example of configuration in which checking transistors 2232 are formed on the array 30 board. The checking transistors 2232 are made by means of polysilicon technology. The checking transistors 2232 are turned on and off by a checking driver circuit 4411. The checking driver circuit 4411 may be formed or constructed of a silicon chip, but preferably the checking transistors 2232 are formed by polysilicon technology (such as CGS technology, high-temperature polysilicon technology, low-temperature polysilicon technology, or the like).

The checking driver circuit 4411 applies turn-on and turn-off voltages to the gate terminals of the checking transistors 2232. By the application of the turn-on voltage, a checking current or detection current applied to the source signal lines 18 is led to the current measuring means 4371. Defects of pixels 16 and the like are detected by means of the detection current. The odd-numbered source signal lines 18 are connected to an ammeter 4317a while the even-numbered source signal lines 18 are connected to an ammeter 4317b. By using a plurality of ammeters 4371, it is possible to improve checking speed and checking accuracy.

After checking, by cutting points A by laser or by a glass cutter, the checking driver circuit 4411 is cut off from the source signal lines 18. Alternatively, the checking driver circuit 4411 may be seemingly cut off from the source signal lines 18 by keeping the checking transistors 2232 off.

Needless to say, the configuration or function of the checking driver circuit 4411 may be incorporated in the source driver circuit (IC) 14. Needless to say, the above is also applicable to other examples of the present invention.

In the example of the present invention, although it has been stated that the currents outputted from pixels 16 are detected and the like (the currents inputted into the pixels 16 may be detected if the driver transistors 11a are N-channel transistors, and the present invention is not limited by the direction of the detection current), this is not restrictive. Voltages may be detected instead of the currents. For example, a voltage can be detected or measured if a pick-up resistor is connected to an end of the source signal line 18. Then, a current flowing through the pick-up resistor can be measured across the resistor. Also, the present invention is not limited to voltage or current. Frequency changes, or intensities or changes of electromagnetic waves, electric lines of force, or emission electrons may be detected.

Although it has been stated that the checking voltage Vc is applied in the checking method according to the present invention in FIG. 437, etc., a checking current may be applied alternatively. Possible methods include, for example, a method which writes a predetermined current Iw into pixels 16 as in the case of current programming according to the present invention, reads the written current by controlling the gate signal lines 17a, and detects or measures the current with ammeters 4371.

Although it has been stated that the gate signal lines 17a (17a1 and 17a2) are controlled in the checking method according to the present invention in FIG. 437, etc., it goes without saying that defects, etc. of transistors 11d and the like can be detected or checked for by applying turn-on and turn-off voltages to the gate signal lines 17b. Needless to say, it is possible to vary, change, or control a turn-on voltage/turn-off voltage of the gate signal lines 17, anode voltage, or cathode voltage, detect or measure resulting changes in the outputs of the source signal lines 18, and thereby detect or assess defects of pixels 16.

The pixel configuration in FIG. 1 or 6 has been cited in FIG. 437. However, the present invention is not limited to this. For example, it is needless to say that the present invention is also applicable to the pixel configuration shown in FIG. 10. The method in FIG. 437 is also applicable to the current-mirror pixel configuration in FIGS. 12 and 13. Similarly, the method can also be applied to the pixel configuration in FIG. 607. By the application of a turn-on voltage to the gate signal lines 17 (17a1 and 17a2), a current can be held in the capacitor 19, and by the application of a turn-off voltage to the gate signal line 17a1, the transistor 11d can be turned off, thereby disconnecting the gate terminal and drain terminal of the driver transistor 11a.

By the application of a turn-on voltage to the gate signal line 17a2, a current path can be formed between the drain terminal of the driver transistor 11a and the source signal line 18. This similarly applies to the pixel configuration in FIGS. 35, 34, etc. Needless to say, the above is also applicable to other examples of the present invention.

The above items apply to the pixel configuration in FIG. 28, etc. By the application of a turn-on voltage to the gate signal lines 17 (17a1 and 17a2), a current can be held in the capacitor 19, and by the application of a turn-off voltage to the gate signal line 17a2, 17a1, a current path can be formed between the drain terminal of the transistor 11a and the source signal line 18.

According to the present invention, a current or voltage is written into the pixels 16, the current, voltage, or the like is read to the source signal lines 18 by manipulating or controlling the gate signal lines 17, and defects of pixels are detected or assessed using the current, voltage, or the like. Needless to say, the above is also applicable to other examples of the present invention.

FIGS. 485 and 486 also show a method of making lighting checks by illuminating the display panel all at once. An anode voltage Vdd and cathode voltage Vss are applied to the display panel. Preferably, a voltage which causes a saturated current to flow through the gate terminals of the driver transistors 11a is applied to the source signal lines 18 using any of the methods in FIGS. 223 to 227, FIGS. 436 to 440, etc.

According to the present invention, a turn-on voltage (Vgl) is applied to the gate signal lines 17a for pixel selection by manipulating the gate driver circuit 12a. It is easy to apply a turn-on voltage to all the gate signal lines 17a at once (FIG. 485(a)). This is because a turn-on voltage can be applied to all the gate signal lines 17a easily by applying an ENBL1 signal to an enable signal line. Of course, a turn-on voltage can be applied to all the gate signal lines 17a by applying an ST1 signal continuously as described with reference to FIG. 14.

When applying a turn-on voltage to the gate signal lines 17a, a turn-off voltage (Vgh) is applied, by manipulating the gate driver circuit 12b, to the gate signal lines 17b which control the current paths for the EL elements 15. It is easy to apply a turn-on voltage to all the gate signal lines 17b at once. This is because a turn-off voltage or a turn-on voltage can be applied to all the gate signal lines 17b easily by applying an ENBL2 signal to an enable signal line. Of course, a turn-on voltage can be applied to all the gate signal lines 17b by applying an ST2 signal continuously as described with reference to FIG. 14.

For checking, a turn-on voltage (Vgl) is applied to all the gate signal lines 17a with a turn-off voltage Vgh applied to all the gate signal lines 17b. The switching transistors 11b and 11c are kept closed. (see FIG. 1 and its description). The switching transistors lid are open. Thus, the potential V applied to the source signal lines 18 is written into the pixels 16 (FIG. 485(b)). To display images uniformly when the EL elements 15 are illuminated, preferably the voltage is such as to cause a saturation current to flow through the driver transistors 11a. The voltage V is lower than the anode voltage Vdd by 3 V or more. Preferably, it is between the anode voltage Vdd minus 4 V and anode voltage Vdd minus 6 V. By the above operation, the driver transistors 11a are programmed with current.

Then, to illuminate the EL elements 15, a turn-off voltage (Vgh) is applied to the gate signal lines 17a as illustrated in FIG. 486, turning off the switching transistors 11b and 11c. Thus, the source signal lines 18 are cut off from the gate terminals of the driver transistors 11a. In this state, a turn-on voltage is applied to the gate signal lines 17b, turning on the switching transistors lid (closing the switching transistors 11d). Consequently, a current Iega corresponding to the voltage V flows from the driver transistors 11a to the EL elements 15, causing the EL elements 15 to illuminate. The illumination is checked optically (by CCD, visually, etc.) to check for or assess defective conditions, faulty conditions, and display uniformity.

However, if V is a saturation voltage of the driver transistors 11a, the current Ie is large. Consequently, the display panel generates a great deal of heat, resulting in overheating. To deal with the overheating, a turn-on voltage and turn-off voltage are applied periodically to the gate signal lines 17b as illustrated in FIG. 486(a) (in which Vgh denotes a turn-off voltage, Vgl denotes a turn-on voltage, and T denotes a period) The turn-on and turn-off voltages can be manipulated easily by manipulating an ENBL2 signal as illustrated in FIG. 485(a).

If the duration of the turn-on voltage t1 in the period T is decreased as illustrated in FIG. 486(a), displayed images become dark, but power consumption is reduced as well. The reduced power consumption prevents the display panel from overheating without reducing display uniformity.

In this way, by performing checking while controlling the current flowing through the EL elements 15, it is possible to perform the checking properly without degrading the panel.

If the driver transistors 11a are normal, when a turn-on voltage Vgl is applied to all the gate signal lines 17b, the current Ie is supplied from the driver transistors 11a to the EL elements 15, causing the EL elements 15 to illuminate. When the EL elements 15 are illuminated, if a turn-on voltage and turn-off voltage are applied alternately to the gate signal lines 17b, the EL elements 15 blink. This makes it possible to determine whether or not the switching transistors 11d are good.

With a turn-off voltage applied to the gate signal lines 17a and a turn-on voltage applied to the gate signal lines 17b, the voltage Vdd applied to the anode terminal is changed periodically in a range below the rising voltage of the driver transistors 11a. The periodic change will cause the EL elements 15 to emit light accordingly.

Incidentally, the light-emitting current of the EL elements 15 is supplied from the driver transistors 11a. The above operation makes it possible to detect performance and defects of the driver transistors 11a as well as switching transistors 11c, 11b, and 11d. Also, performance and characteristics of the driver transistors 11a and EL elements 15 can be assessed.

Although it has been stated with reference to FIG. 485 that a turn-on voltage is applied to all the gate signal lines 17a or that a turn-on voltage or turn-off voltage is applied to all the gate signal lines 17b, the present invention is not limited to this. Needless to say, odd-numbered pixel rows or even-numbered pixel rows may be selected for illumination or checking. That is, the present invention can use any checking method as long as it makes optical checks by selecting and illuminating multiple pixel rows. Although the examples of FIG. 485 is described by mainly taking the pixel configuration in FIG. 1 as an example, this is not restrictive. Any configuration may be used as long as it can control the illumination of EL elements 15. Needless to say, the checking method is applicable, for example, to the pixel configurations in FIGS. 6, 7 to 13, 31 to 36, 193 to 194, 205 to 207, 211 to 212, 215 to 222, 437, 438, 467, etc.

Although it has been stated in the above example that checking is performed by detecting the current flowing through the source signal lines 18, this is not restrictive. Needless to say, checking may be performed by attaching an ammeter 4371 to the anode terminal as illustrated in FIG. 490(a). Needless to say, checking may be performed by attaching an ammeter 4371 to the cathode terminal as illustrated in FIG. 490(b). Needless to say, the above is also applicable to other examples of the present invention.

Although in the above example, checking is performed on a diced display panel (display apparatus or array board 30), the present invention is not limited to this. Checking may be performed on a glass substrate 4881 (on which a plurality of arrays 30 or panels are formed) as illustrated in FIG. 488. The anode voltage (Vdd), Vgh voltage, Vgl voltage, ENBL1, ENBL2 (see FIG. 485), and voltage (Vs) applied to the source signal lines 18 are applied (connected) to the glass substrate 4881. The cathode voltage (Vss) and the like are also applied (connected) as required.

Signal wiring 4891 is formed or placed on the glass substrate 4881 as illustrated in FIG. 489. The source driver circuit (IC) 14 is not mounted at the time of checking. The signal wiring 4891 is constructed or formed such that a voltage or signal is applied commonly to each array board 30. After the checking the glass substrate 4881 is diced into separate array boards 30 along BB′ line and AA′ line.

The drive methods in FIGS. 223 to 227, 436 to 440, 485, and 486 can be used in combination. A flowchart of the checking method according to the present invention is shown in FIG. 440. According to the present invention, pixels are checked for defects on the array as described with reference to FIGS. 437, 438, etc. At this stage, TFT defects, line defects, etc. ascribable to driver transistors and the like are detected. Then, after the panel is completed, the entire screen 144 is illuminated and checked (all-at-once lighting check) using the method shown in FIG. 436 as illustrated in FIG. 440. If the all-at-once lighting check reveals no problem (Y), the panel is sent to the process of COG-mounting the source driver IC 14. If the all-at-once lighting check reveals a problem (NG), the panel is discarded. If no decision is reached (N), the panel is assessed by illuminating it on a pixel-by-pixel basis. Electric current lighting check is performed. If the lighting check reveals no problem (Y), the panel is sent to the process of COG-mounting the source driver IC 14. After the COG-mounting, a final lighting check is carried out.

With reference to drawings, description will be given below of a high-quality display method based on current driving (current programming). Current programming involves applying current signals to the pixels 16 and making the pixels 16 retain the current signals. Then the retained current is applied to the EL elements 15.

The EL elements 15 emit light in proportion to the applied current. That is, the emission brightness of the EL elements 15 has a linear relationship (proportionality) with programmed current. On the other hand; in the case of voltage programming, applied voltage is converted into current in the pixels 16. The voltage-current conversion is non-linear. Non-linear conversion involves a complicated control method.

In current programming, values of video data are converted directly into programming current linearly. To take a simple example, in the case of 64 gradation display, video data 0 is converted into a programming current Iw=0 μA and video data 63 is converted into a programming current Iw=6.3 μA (proportionality exists). Similarly, video data 32 is converted into a programming current Iw=3.2 μA and video data 10 is converted into a programming current Iw=1.0 μA. In short, video data are converted into programming current in direct proportion.

For ease of understanding, it has been stated that video data are converted into programming current in direct proportion. Actually, however, video data can be converted into programming current more easily. This is because according to the present invention, a unit current of the unit transistor 154 corresponds to video data 1 as illustrated in FIG. 15. Furthermore, the unit current can be adjusted easily to a desired value by adjusting reference current circuits. Besides, separate reference currents are provided for R, G, and B circuits and a white balance can be achieved over the entire gradation range by adjusting the R, G, and B reference current circuits. This is a result of synergy among current programming, the source driver circuits(IC) 14 of the present invention, and the configuration of the display panel.

EL display panels are characterized in that the emission brightness of the EL elements 15 has a linear relationship with programming current. This is a major feature of current programming. Thus, if the magnitude of the programming current is controlled, the emission brightness of the EL elements 15 can be adjusted linearly.

The relationship between the voltage applied to the gate terminal of the driver transistor 11a and the current passed through the driver transistor 11a is non-linear (often results in a quadratic curve). Therefore, in voltage programming, there is a non-linear relationship between programming voltage and emission brightness, making it extremely difficult to control light emission. In contrast, current programming makes light emission control extremely easy.

In particular, with the configuration shown in FIG. 1, the programming current is theoretically equal to the current flowing through the EL element 15. This makes light emission control extremely easy. The N-fold pulse driving according to the present invention also excels in light emission control because the emission brightness can be determined by dividing the programming current by N.

If pixels have a current-mirror configuration as in the case of FIGS. 11, 12 and 13, the driver transistor 11b and programming transistor 11a are different, which causes a deviation in the current mirror ratio, introducing an error factor into emission brightness. However, the pixel configuration in FIG. 1, in which the driver transistor and programming transistor are identical, is free of this problem.

The emission brightness of the EL element 15 changes in proportion to the amount of supplied current. The value of the voltage (anode voltage) applied to the EL element 15 is fixed. Therefore, emission brightness of the EL display panel is proportional to power consumption.

Thus, video data is proportional to programming current, which is proportional to the emission brightness of the EL element 15, which in turn is proportional to power consumption. Therefore, by performing logic processes on the video data, it is possible to control the power consumption (power), emission brightness, and power consumption of the EL display panel. That is, by performing logic processes (addition, etc.) on the video data, it is possible to determine the brightness and power consumption of the EL display panel. This makes it extremely easy to prevent peak current from exceeding a set value.

The present invention performs lighting ratio control, duty ratio control, reference current control, etc. by adding video data and thereby determining the current (voltage) consumed by the panel. However, the drive method according to the present invention is not limited to adding video data. It also determines the currents flowing through EL elements 15 from the video data according to the gamma curve of the pixels 16 and adds the determined currents. Higher accuracy is available if operations such as additions are performed on all the pixels on the display panel. However, needless to say, pixels may be added or the like by selecting them at predetermined intervals. Then, the current (voltage) consumed by the panel may be determined based on the results of additions. That is, any method that performs logic processes (which may be either software processes or hardware processes) on video data, for example, to determine the current consumption of the panel, is included within the technical scope of the present invention. Incidentally, the addition may be either a software process or hardware process. Operations by means of bit shifts, subtraction processes, division processes, pipeline processes, etc. may also be used. The control circuit (IC) 760 or DSP may be used for operations. Thus, the technical scope of the present invention is not limited to addition, but includes performing some logic processes on video data.

For example, the current (voltage) consumed by the panel may be determined by operating on video data (including data similar to video data) using a gamma value of 2.2. That is, the total current flowing through the display panel is determined in real time or intermittently by adding the results of operations performed using the gamma value of 2.2. Of course, an average current over a certain period may be determined. In some cases, the current (voltage) consumed by the panel may be determined using a gamma value of −2.2. The current (power) consumption of the panel is determined using a relationship (arithmetic expression) between the current (voltage) signal applied to the source signal lines 18 and the current flowing through the EL elements 15 of the pixels 16.

In the case of current driving, the current signal applied to the source signal lines 18 is proportional to the current flowing through the EL elements 15 of the pixels 16 and the current (power) consumption of the panel can be determined easily by addition. In the case of voltage driving, the relationship is non-linear, and the current (power) consumption of the panel can be determined using a fixed multiplier (preferably the start-up position of output current is also taken into consideration). In the case of dynamic gamma processing, preferably the current (power) consumption of the panel is determined by taking gamma conversion characteristics into consideration.

The current (power) consumed by the panel may be determined from signal changes represented by combined characteristics of the pixels 16 or source driver circuit (IC) 14, and a conversion formula of the current flowing through the EL elements 15 of the pixels 16. If gamma characteristics are approximated by polygonal curves, the current (power) consumed by the panel may be determined by adding the currents outputted from respective reference current circuits, taking into consideration the magnitude of a reference current from each reference current circuit represented by each polygonal curve.

Although the current (power) consumed by (used in) the panel is determined by logic means in the above example, lighting ratio control, duty ratio control, reference current control, etc. may be performed by determining the currents flowing through the anode (cathode) signal lines or the like digitally through AD conversion. Alternatively, lighting ratio control, duty ratio control, reference current control, etc. may be performed by determining the currents flowing through the anode (cathode) signal lines or the like in an analog fashion. Also, the currents flowing through the display panel or the like can be determined using signals obtained by opto-electric conversion with photosensors or the like. A method which involves capturing electric lines of force radiated from the panel is also available. Thus, lighting ratio control, duty ratio control, reference current control, etc. may be performed using the signals obtained by the electric conversion.

Each of the lighting ratio control, duty ratio control, reference current control, etc. according to the present invention constitutes an important invention by itself. A method which performs logic processes (which may be either software processes or hardware processes) on video data, for example, to determine the current consumption of the panel, constitutes an important invention by itself.

In duty ratio control and the like, in particular, the capability to shut off the current flowing through the EL elements 15 as required and thereby control the current consumption of the panel owes greatly to the function of the transistors 11d of the pixel 16 (the transistor which, being placed between the EL element 15 and the driver transistor 11a, controls the current flowing through the EL element in the case of FIG. 1 and the transistor which similarly controls the current flowing through the EL element in the case of pixels 16 of a different configuration). This is because the transistors 11d connected to the gate signal lines 17b can be turned on and off easily by controlling the gate driver circuits 17b according to the lighting ratio. Increasing the number of transistors 11d turned off reduces the current consumed by the panel in proportion. Increasing the number of transistors 11d turned on increases the quantity of light radiated by the panel, resulting in increased display brightness. Thus, using the unique configuration of the present invention (the pixels, transistors 11d, the gate driver circuits 12, gate signal lines 17b, transistors 11d, etc.)., it is possible to implement lighting ratio control, duty ratio control, and reference current control properly. These control methods make it possible to extend the life of the heat generation of the panel and reduce the size of the power supply module.

Needless to say, the above items are applicable to both voltage driving (voltage programming) and current driving (current programming). For ease of explanation, the drive method according to the present invention is described based mainly on the pixel configuration in FIG. 1. However, the present invention is not limited to this. Needless to say, for example, the drive method is also applicable to the pixel configurations in FIGS. 2, 6 to 13, 28, 31, 33 to 36, 158, 193 to 194, 574, 576, 578 to 581, 595, 598, 602 to 604, 607(a), 607(b), and 607(c).

In particular, the EL display panel of the present invention is a current-driven type. In addition, characteristic configuration makes it easy to control image display. There are two characteristic image display control method. One of them is reference current control. The other is duty cycle control. The reference current control and cycle control, when used singly or in conjunction, can achieve a wide dynamic range, high-quality display, and high contrast.

To begin with, regarding reference current control, the source driver circuit (IC) 14 is equipped with circuits which control RGB reference currents, as illustrated in FIGS. 60, 61, 64, 65, 66(a), 66(b) and 66(c). The magnitude of the programming current Iw flowing from the source driver circuit (IC) 14 depends on the number of the unit transistors 154.

The current outputted by one unit transistor 154 is proportional to the magnitude of the reference current. Thus, as the reference current is adjusted, the current outputted by one unit transistor 154 and the magnitude of the programming current are determined. The reference current and the output current of the unit transistor 154 have a linear relationship and the programming current and brightness have a linear relationship. Therefore, if the RGB reference currents and white balance are adjusted in white raster display, the white balance can be maintained for all gradations.

FIG. 54 shows duty cycle control methods. FIGS. 54(a1), 54(a2), 54(a3), 54(a4), shows a method of inserting a non-display area 192 continuously. This method is suitable for movie display. The image in FIG. 54(a1) is the darkest and the image in FIG. 54(a4) is the brightest. The duty ratio can be changed easily through control of the gate signal line 17b. FIGS. 54(c1), 54(c2), 54(c3), 54(c4) shows a method of inserting a non-display area 192 by dividing it into multiple parts. This method is suitable especially for still picture display. The image in FIG. 54(c1) is the darkest and the image in FIG. 54(c4) is the brightest. The duty ratio can be changed easily through control of the gate signal line 17b. FIGS. 54(b1), 54(b2), 54(b3), 54(b4) shows something in between FIG. 54(a1) to 54(a4) and FIG. 54(c1) to 54(c4). Again, the duty ratio can be changed easily through control of the gate signal line 17b. That is, the current flowing through the EL element 15 is controlled by controlling the gate signal line 17b and the like and thereby turning on and off the transistor 11d.

The transistor 11e is turned on and off and in the pixel configuration in FIGS. 11 and 12 and the selector switch 71 is turned on and off in FIG. 7. On the other hand, the current flowing through the EL element 15 is controlled by controlling the transistor 11d in the pixel configuration in FIG. 28.

Thus, duty ratio control consists in controlling the brightness of the screen 144 by controlling the currents flowing through the EL elements 15 without varying programming currents Iw applied to the source signal lines 18. That is, the brightness of the screen 144 is controlled with the reference currents kept constant (without varying the reference currents).

The brightness of the screen 144 is controlled without varying the currents passed by the driver transistors 11a. Also, the brightness of the screen 144 is controlled without changing the voltages at the gate (G) terminals of the driver transistors 11a. Also, the brightness of the screen 144 is controlled by changing the scanning mode of the gate driver circuit 12b and thereby controlling the gate signal line 17b.

If the number of pixel rows is 220 and the duty ratio is ¼, since 220/4=55, the brightness of the display area 193 can be varied from 1 to 55 (from brightness 1 to 55 times the brightness 1). Also, if the number of pixel rows is 220 and the duty ratio is ½, since 220/2=110, the brightness of the display area 53 can be varied from 1 to 110 (from brightness 1 to 110 times the brightness 1). Thus, the adjustable range of the screen brightness 144 is very wide (the dynamic range of image display is wide). Also, the number of gradations which can be expressed is the same at any brightness. For example, in the case of 64 gradation display, 64 gradations can be displayed whether the brightness of the display screen 144 in white raster display is 300 nt or 3 nt.

As described earlier, the duty ratio can be changed easily through control of the start pulse applied to the gate driver circuit 126. Thus, it can be easily changed to any of various values, including ½, ¼, ¾, and ⅜.

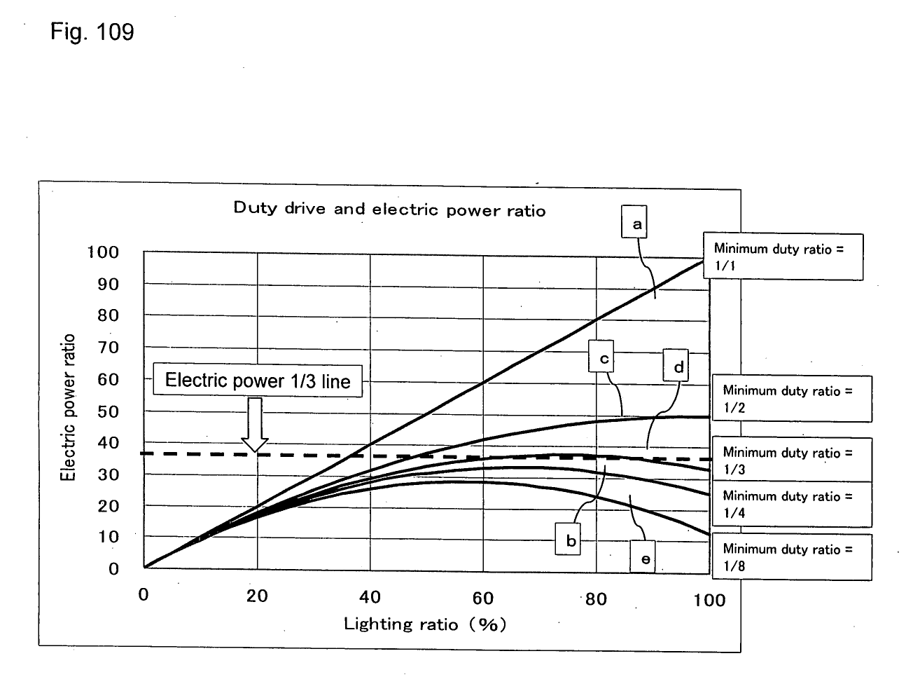

Duty ratio driving based on a unit duration of one horizontal scanning period (1 H) can be achieved by the application of on/off signals to the gate signal line 17b in sync with a horizontal synchronization signal. However, duty cycle control can also be performed using a unit duration shorter than 1 H. Such drive methods are shown in FIGS. 40, 41 and 42. Brightness (duty ratio) can be controlled in fine steps through OEV2-based control at intervals of 1 H or less (see also FIGS. 109 and 175 and their description).

Duty cycle control at intervals of 1 H or less should be performed when the duty ratio is ¼. If the number of pixel rows is 200, the duty ratio is 55/220 or less. That is, the duty cycle control should be performed with a duty ratio in the range of 1/220 to 55/220. It should be performed when a single step causes a change of 1/20 (5%) or more. More preferably, fine duty ratio driving control should be performed using OEV2-based control even if a single change is 1/50 (2%) or less. That is, in the duty cycle control by means of the gate signal line 17b, if a single step produces a brightness change of 5% or more, OEV2-based control(see FIG. 40, etc.) should be used to change brightness little by little in such a way as to keep the amount of single change within 5%. Preferably, this is done using a Wait function described with reference to FIG. 98.

In duty cycle control at a duty ratio of ¼ and at intervals of 1 H or less, a single step produces a large change. Besides, even minute changes tend to be perceived visually due to halftone image display. Human vision has low detection capability with respect to brightness on a screen darker than ascertain level. Also, it has low detection capability with respect to brightness changes on a screen brighter than a certain level. It is believed that this is because human vision has square-law characteristics.

If the number of pixel rows in the panel is 200, duty cycle control is performed at intervals of 1 H or less using OEV2-based control at a duty ratio of 50/200 or less (from 1/200 to 50/200 both inclusive). When the duty ratio changes from 1/200 to 2/200, the difference between 1/200 and 21/200 is 1/200, meaning a 100% change. This change is fully perceived visually as flickering. Thus, the current supply to the EL elements 15 is controlled by OEV2-based control (see FIG. 40, etc.) at intervals of 1 H (one horizontal scanning period) or less. Incidentally, although it has been stated that duty cycle control is performed at intervals of 1 H or less, this is not restrictive. As can be seen from FIG. 19, the non-display area 192 is continuous. This means that control at intervals of 10.5 Hs is also included in the scope of the present invention. Thus, the present invention performs duty cycle control at intervals which is not limited to 1 H (and which may contain a decimal part).

When the duty ratio changes from 40/200 to 41/200, the difference between 40/200 and 41/200 is 1/200, meaning a ( 1/200)/( 40/200) or 2.5% change. Whether this change is perceived visually as flickering is highly likely to depend on the brightness of the screen 144. However, the duty ratio of 40/200 means a halftone display, which is related to high visual sensitivity. Thus, it is desirable to control the current supply to the EL elements 15 by means of OEV2-based control (see FIG. 40, etc.) at intervals of 1 H (one horizontal scanning period) or less.

Thus, the drive method and display apparatus of the present invention generate at least the display mode shown in FIG. 19 for display images (the display area 193 may occupy the display screen 144 (meaning a duty ratio of 1/1 depending on the brightness of the images) in a display panel comprising means (e.g., the capacitor 19 in FIG. 1) of storing the values of current to be passed through the EL elements 15 in the pixels 16 and means (e.g., the pixel configuration in FIG. 1, 6, 7, 8, 9, 10, 11, 12, 28 and 31 to 36, or the like) of turning on and off the current paths between the driver transistors 11a and light-emitting elements (e.g., the EL elements 15). Also, in duty ratio driving (a drive method or drive mode in which at least part of the display screen 144 is occupied by a non-display area 193) at a duty ratio not higher than a predetermined value, the drive method and display apparatus of the present invention control the brightness of the display screen 144 by controlling the current passed through the EL elements 15 for a unit duration of one horizontal scanning period (period of 1 H) or less.

Duty cycle control based on a unit duration of 1H or less should be performed when the duty ratio is ¼ or less. Conversely, when the duty ratio is not lower than a predetermined value, duty cycle control should be performed using a unit duration of 1 H or no OEV2-based control should be performed. Duty cycle control using a unit duration of other than 1 H should be performed when a single step causes a change of 1/20 (5%) or more. More preferably, fine duty ratio driving control should be performed using OEV2-based control even if a single change is 1/50/ (2%) or less. Alternatively, it should be performed at a brightness ¼ or less the maximum brightness of white raster.

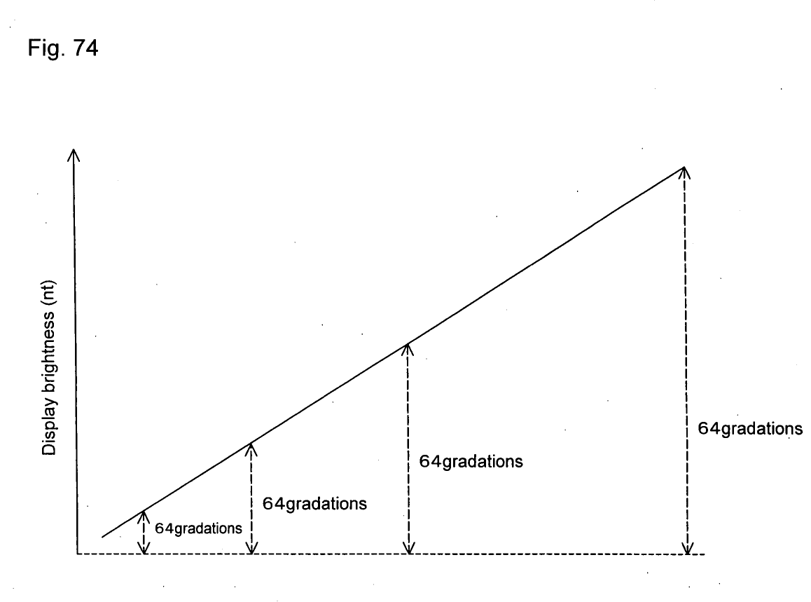

The duty cycle control driving according to the present invention allows an EL display panel capable of, for example, 64-gradation display to maintain 64-gradation display regardless of the display brightness (nt) of the display screen 144 (whether the brightness is low or high), as illustrated in FIG. 74. For example, even if the number of pixel rows is 220 and only one pixel row constitutes a display area 193 (is in display mode) (the duty ratio is 1/220), a 64-gradation display can be achieved. This is because images are written into one after another of pixel rows by the programming current Iw from the source driver circuits (IC) 14 and the images are displayed by one after another of the pixel rows. When all the pixel rows constitute a display area 193 (i.e., when all the pixel rows are in display mode), a 64-gradation display can be achieved as well even if the duty ratio is 1/1.

Of course, when the 20 pixel rows constitute a display area 193 (are in display mode) (the duty ratio is 20/200= 1/11), a 64-gradation display can be achieved as well. This is because images are written into one after another of pixel rows by the programming current Iw from the source driver circuits (IC) 14 and the images carried by all the pixel rows are displayed at once by the gate signal lines 17b. Also, when only 20 pixel rows constitute a display area 53 (are in display mode) (the duty ratio is 20/200= 1/11), a 64-gradation display can be achieved as well. This is because images are written into one after another of pixel rows by the programming current Iw from the source driver circuits (IC) 14 and the images are displayed as the 20 pixel rows are scanned one after another by the gate signal lines 17b.

The same holds for reference current control (see the circuit configuration in FIG. 50, etc.) and a 64-gradation display can be achieved regardless of the magnitudes of reference currents.

Since the duty cycle control driving according to the present invention controls the illumination time of the EL elements 15, there is a linear relationship between the duty ratio and the display screen 144 brightness. This makes it extremely easy to control image brightness, simplify signal processing circuits, and reduce costs. As shown in FIG. 60, the RGB reference currents are adjusted to achieve a white balance. In duty cycle control, since RGB brightness is controlled simultaneously, white balance is maintained at any gradation and at any display screen 144 brightness.

Duty cycle control consists in varying the brightness of the display screen 144 by varying the size of the display area 193 in relation to the display screen 144. Naturally, current flows through the EL display panel in approximate proportion to the display area 193. Therefore, by determining the sum of video data, it is possible to calculate the total current consumption of the EL elements 15 of the display screen 144. Since the anode voltage Vdd of the EL elements 15 is a direct voltage and its value is fixed, if the total current consumption can be calculated, total power consumption can be calculated in real time according to image data. If the calculated total power consumption is expected to exceed prescribed maximum power, the RGB reference currents in FIG. 60 can be controlled through adjustment of a regulator circuit such as an electronic regulator.

Brightness is preset during white raster display in such a way as to minimized the duty ratio at this time. For example, the duty ratio is set to ⅛. The duty ratio is increased for natural images. The maximum duty ratio is 1/1. The duty ratio available when a natural image is displayed in only 1/100 of the display screen 144 is taken as 1/1. The duty ratio is varied smoothly from 1/1 to ⅛ based on display condition of natural images of the display screen 144.

Thus, as an example, the duty ratio is set to ⅛ during white raster display (a state in which 100% of the pixels are illuminated in white raster display) and is set to 1/1when 1/100 of the pixels on the display screen 144 are illuminated. The duty ratio can be calculated approximately using the formula: “the number of pixels”×“ratio of illuminated pixels”×“duty ratio.”

If it is assumed for ease of explanation that the number of pixels is 100, the power consumption for white raster display is 100×1 (100%)×⅛(duty ratio)=80. On the other hand, the power consumption for natural image display for which 1/100 of pixels illuminate is 100× 1/100(1%)× 1/1(duty ratio)=1. The duty ratio is varied smoothly from 1/1 to ⅛ according to the number of illuminated pixels of images (actually, total current drawn by illuminated pixels=sum total of programming currents per frame) so that no flickering will occur.

Thus, the power consumption ratio for white raster display is 80 and the power consumption ratio for natural image display for which 1/100 of pixels illuminate is 1. Therefore, by presetting a brightness during white raster display in such a way as to minimized the duty ratio at this time, it is possible to reduce the maximum current.

The present invention performs drive control using S×D, where S is the sum total of programming currents per screen and D is a duty ratio. Also, the present invention provides a drive method which maintains a relationship Sw×Dmin≧Ss×Dmax as well as a display apparatus which implements the drive method, where Sw is the sum total of programming currents for white raster display, Dmax is the maximum duty ratio (normally, the maximum duty ratio is 1/1), Dmin is the minimum duty ratio, and Ss is the sum total of programming currents for an arbitrary natural image.

Incidentally, it is assumed that the maximum duty ratio is 1/1. Preferably, the minimum duty ratio is 1/16 or above (⅛ and the like). That is, the duty ratio should be from 1/16 to 1/1(both inclusive). Needless to say, it is not strictly necessary to use the duty ratio of 1/1. Preferably, the minimum duty ratio is 1/10 or above. To small a duty ratio makes flickering conspicuous as well as causes screen brightness to vary greatly with the image content, making the image hard to see.

As described earlier, programming current is proportional to video data. Thus, “the sum total of programming currents” is synonymous with “the sum total of programming currents.” Incidentally, although it has been stated that the sum total of programming currents is determined over one frame (field) period, this is not restrictive. It is also possible to determine the sum total of programming currents (video data) by sampling pixels which add to programming currents at predetermined intervals or on a predetermined cycle during one frame (field) period. Alternatively, it is also possible to use the total sum before and after the frame (field) period to be controlled. Also, an estimated or predicted total sum may be used for duty cycle control.

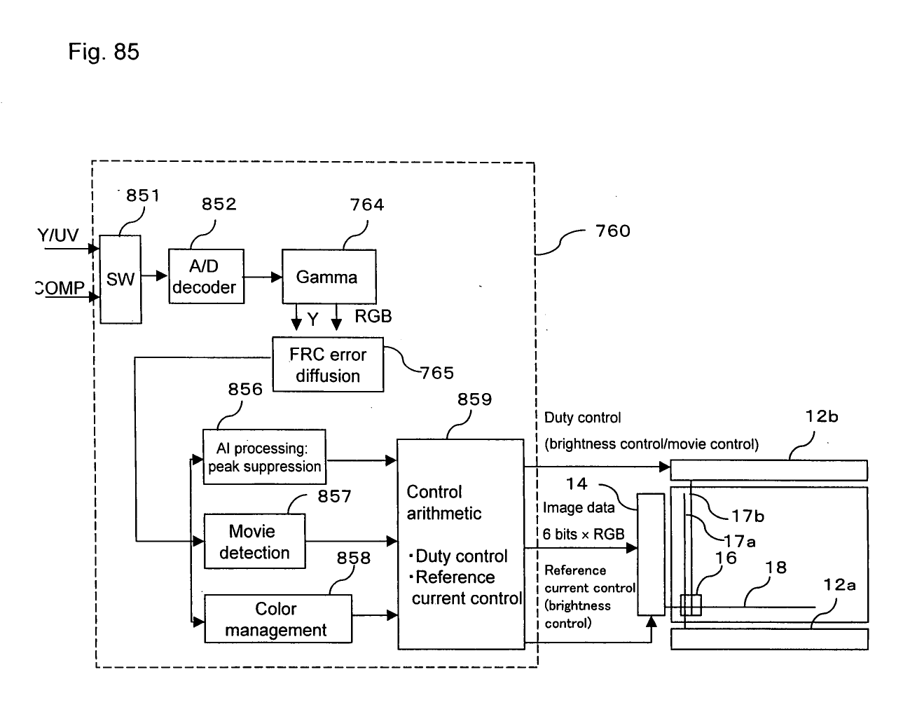

FIG. 85 is a block diagram of a drive circuit according to the present invention. The drive circuit according to the present invention will be described below. The drive circuit in FIG. 85 is configured to receive input of a Y/UV video signal and composite (COMP) video signal. Of the two signals, the one to be input is selected by a switch circuit 851.

The video signal selected by the switch circuit 851 is subjected to decoding and A/D conversion by a decoder and A/D converter, and thereby converted into digital RGB image data. Each of the R, G, and B image data is 8-bit data. Also, the RGB image data go through gamma processing in a gamma circuit 854. At the same time, a luminance (Y) signal is determined. As a result of the gamma processing, each of the R, G, and B image data is converted into 10-bit data.

After the gamma processing, the image data are subjected to an FRC process or error diffusion process by a processing circuit 855. The RGB image data are converted into 6-bit data by the FRC process or error diffusion process. Then, the image data are subjected to an AI process of peak current process by an AI processing circuit 856. Also, movie detection is carried out by a movie detection circuit 857. At the same time, color management process is performed by a color management circuit 858.

Results of the processes performed by the AI processing circuit 856, movie detection circuit 857, and color management circuit 858 are sent to an arithmetic circuit 859 and converted by the arithmetic circuit 859 into data for use in control operations, duty cycle control, and reference current control. The resulting data are sent to the source driver circuit 14 and gate driver circuit 12 as control data.

Preferably, duty ratio control, and reference current control, peak current control, etc. are not used for OSD (on-screen display). OSD is used to display a menu screen and the like on video cameras and the like. The use of peak current control in OSD will cause variations in the brightness of the screen according to display conditions of a menu, resulting in an unsatisfactory visual display.

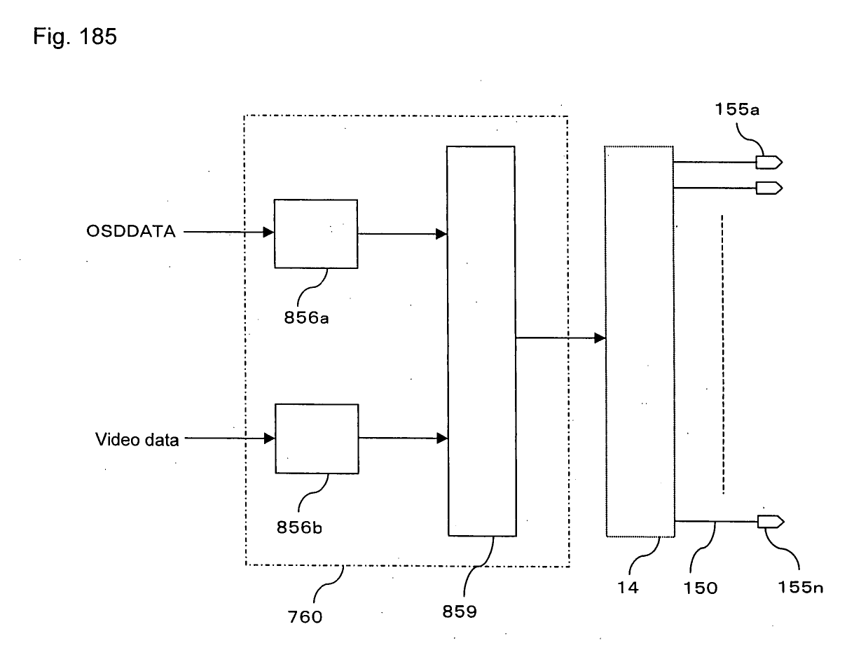

To deal with this problem, OSD data (OSDDATA) and video data (moving picture data) are processed by different control circuits 856 as illustrated in FIG. 185. Basically, the OSD data is not subjected to intensity modulation.

Incidentally, the controller circuit (IC) 760 may be implemented not only as a single chip. For example, as illustrated in FIG. 248, it may be divided into a controller circuit (IC) 760G which controls the gate driver circuits 12 and a controller circuit (IC) 760S which controls the source driver circuit (IC) 14. This makes it possible to clarify process details and reduce the size of the controller ICs.

The data for use in duty cycle control is sent to the gate driver circuit 12b, which performs duty cycle control. On the other hand, the data for use in duty cycle control is sent to the source driver circuit (IC) 14, which performs reference current control. The image data subjected to the gamma correction as well as to the FRC or error diffusion process are also sent to the source driver circuit (IC) 14.

The image data conversion in FIG. 62 should be performed by way of a gamma process in the gamma circuit 854. The gamma circuit 834 performs gradation conversion using multi-point polygonal gamma curves. 256-gradation image data are converted into 1024-gradation image data using multi-point polygonal gamma curves. Although it has been stated that the gamma circuit 854 performs a gamma process using multi-point polygonal gamma curves, this is not restrictive.

Incidentally, it has been stated that the duty ratio D is used for control, and the duty ratio is the ratio of an illumination period of the EL elements 15 to a predetermined period (normally one field or one frame. In other words, this is generally a cycle or time during which image data of any given pixel is rewritten). Specifically, a duty ratio of ⅛ means that the EL elements 15 illuminate for ⅛ of one frame period (1F/8) Thus, the duty ratio is given by: duty ratio=Ta/Tf, where Tf is the cycle/time during which the pixels 16 are rewritten and Ta is the illumination period of the pixels.

Incidentally, although it has been stated that Tf denotes the cycle/time during which the pixels 16 are rewritten and that Tf is used as a reference, this is not restrictive. The duty ratio control driving according to the present invention does not need to be completed in one frame or one field. That is, the duty ratio control may be performed using a few fields or few frame periods as one cycle. Thus, Tf is not limited to the cycle during which the pixel 16 is rewritten. It may be one frame/field or more. For example, if the illumination period Ta varies from field to field (or from frame to frame), the total illumination period Ta during a repetition cycle (period) Tf may be adopted. That is, average illumination time over a few fields or few frame periods may be used as Ta. The same applies to the duty ratio. If the duty ratio varies from field to field (or from frame to frame), the average duty ratio over a few frames (fields) may be calculated and used.

Thus, the present invention provides a drive method which maintains a relationship Sw×(Tas/Tf)≧Ss×(Tam/Tf) as well as a display apparatus which implements the drive method, where Sw is the sum total of programming currents for white raster display, Ss is the sum total of programming currents for an arbitrary natural image, Tas is the minimum illumination period, and Tam is the maximum illumination period (normally, Tam=Tf, and thus Tam/Tf=1).

As illustrated in, or described with reference to, FIGS. 60, 61, 64 and 65, the programming current can be adjusted linearly through control of the reference current. This is because the output current of each unit transistor 154 changes. As the output current of the unit transistor 154 is varied, the programming current Iw changes as well. The larger the current (actually, the voltage which corresponds to the programming current) programmed into the capacitor 19 of a pixel, the larger the current flowing through the EL element 15. The current flowing through the EL element is linearly proportional to emission brightness. Thus, by varying the reference current, it is possible to vary the emission brightness of the EL element linearly.

As described above, the source driver circuit (IC) 14 according to the present invention varies the programming currents Iw by controlling the number of unit transistors 154 connected to the terminals 155. Also, the programming currents Iw are created by varying the reference currents Ic as described with reference to FIGS. 60, 62, etc.

However, the reference current control and the like according to the present invention are not limited to this. They can employ any method that can change the currents outputted from the terminals 155 by varying a certain reference (voltage, current, setting data). It is important, however, that the programming currents Iw from the different output terminals 155 are varied in the same proportion along with changes in the reference. Also, what can be varied is not limited to the programming currents Iw, and programming voltages may be varied instead. By varying the programming voltages at the different terminals 155 in the same proportion, the brightness of the display screen 144 can be adjusted. Also, by varying the programming voltages among R, G, and B terminals, white balance can be adjusted.

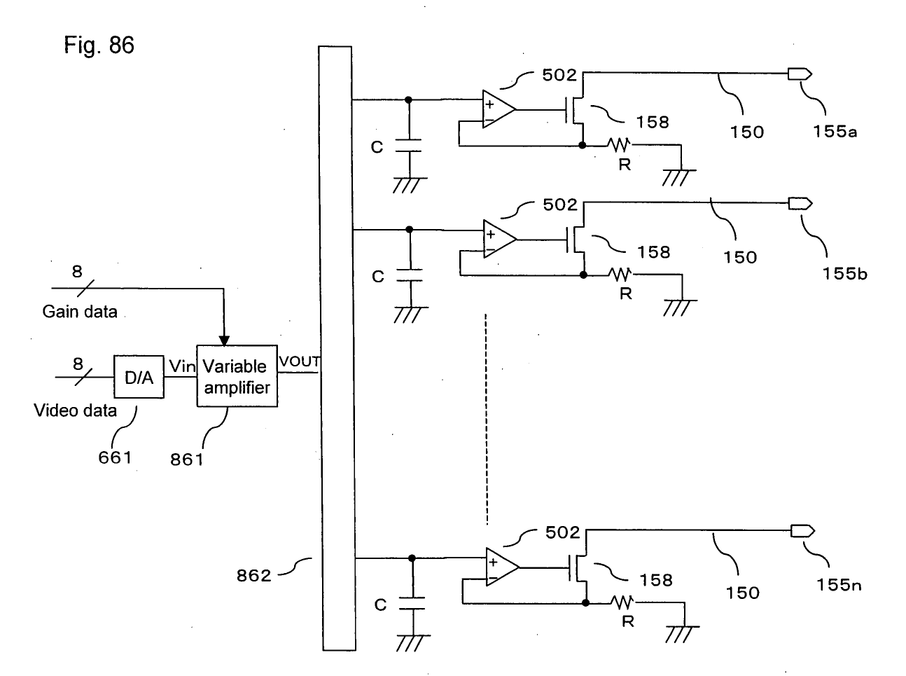

FIG. 86 shows an example of the present invention which has no adjustment circuit for reference currents Ic. Programming currents Iw are supplied to terminals 155 from the transistors 156 with operational amplifiers 502. The programming currents Iw are determined by voltages applied to the operational amplifiers 522 by the sampling circuit 862.

Eight-bit video data is converted into analog data by the D/A circuit 661 and the analog data has its gain adjusted by a variable amplifier circuit 861. The gain-adjusted analog data is sampled by the sampling circuit 862 in sync with a horizontal scanning clock and held in respective capacitors C. The gain of the variable amplifier circuit 861 is set by 8-bit data.

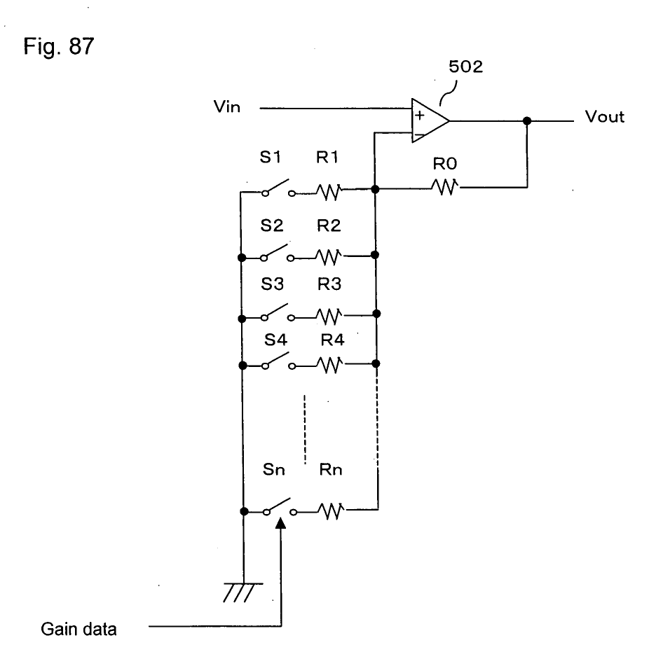

A configuration example of the variable amplifier circuit 861 is cited in FIG. 87, in which analog data of the D/A circuit 661 is applied to a terminal Vin. The gain is set by switches Sx connected in series to resistors Rx. The switches Sx are controlled by 8-bit gain setting data. The gain setting data can be varied every frame or every field.

With the above configuration, by controlling the gain setting data in FIG. 87, it is possible to vary output currents from the terminals 155 in proportion to (in correlation with) the value of control data.

That is, the gain is set by closing one of the switches Sx. The switches Sx serve the same function as the switches in the switch circuits 642 in FIG. 64 or the switches in the electronic regulators 501 in FIG. 50. In other words, by controlling the switches Sx, the programming currents Iw can be varied or adjusted.

Thus, in FIG. 86, the analog data is sampled and held in C. The sampled and held voltages cause the programming currents Iw to be applied to the source signal lines 18. The programming currents Iw are varied (controlled) based on the gain data of the variable amplifier circuit 861.

The configuration in FIG. 86 also allows the brightness of the display screen 144 to be adjusted (varied) all at once by the gain setting data. This makes it possible to implement the N-fold pulse driving, duty ratio driving, etc. according to the present invention. Incidentally, no unit transistor 154 is formed in the configuration in FIG. 86, etc. Thus, the present invention is characterized by a configuration which allows reference currents to be adjusted with electronic regulators, thereby allowing currents from all the output terminals 155 of the source driver circuit (IC) 14 to be varied proportionally. As described later, the reference currents are determined from the video data. That is, the configuration or method here allows the magnitudes of the currents from the output terminals 155 to be varied based on feedback from the video data.

Incidentally, although the signal outputted from the terminal in the above example is current, voltage may be used alternatively. This is because a voltage signal can control the current flowing through the EL elements 15 (and thus the current flowing from the video data to the cathode (anode) terminal). In other words, the present invention is characterized by a configuration which makes it possible to determine the magnitudes or variation amounts of the reference currents from the video data and vary the currents from all the output terminals 155 of the IC 14 proportionally by adjusting the reference currents.

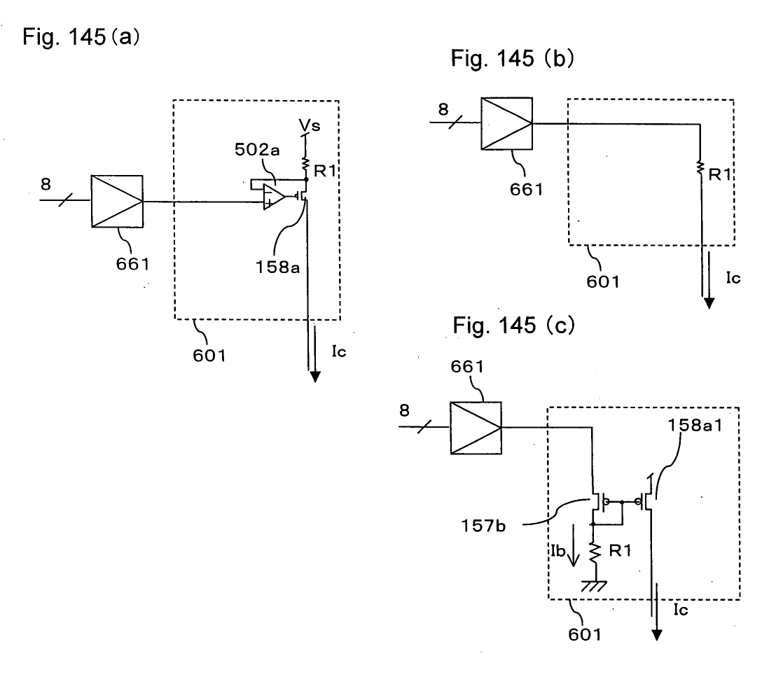

By providing separate variable amplifier circuits 861 for R, G, and B, it is possible to implement white balance control and color management control (see FIGS. 145 to 153). That is, in the display panel or display apparatus according to the present invention, the drive method and configuration according to the present invention can also be implemented using the source driver circuit (IC) 14 of the configuration shown in FIG. 86.

The present invention controls the brightness of the display screen 144 and the like using at least one of the reference current control method described with reference to FIG. 60, etc. and the duty ratio control method described with reference to FIGS. 54(a), 54(b), 54(c), etc. Preferably, the reference current control method and duty ratio control method are used in combination.

Further, a drive method according to the present invention will be described. One object of the present invention is to place an upper limit on the current consumption of EL display panels. In EL display panels, there is proportionality between the current flowing through the EL element 15 and emission brightness. Thus, by increasing the current flowing through the EL element 15, the EL display panel can be made ever brighter. The current consumed (=current consumption) also increases in proportion to the brightness.

In the case of mobile device such as portable apparatus and the like, there are limits to battery capacity and the like. Also, a power supply circuit increases in scale with increases in current consumption. Thus, it is necessary to place limits on current consumption. It is an object of the present invention to place such limits (peak current control).

Also, increasing image contrast improves display. By converting images into high-contrast images (with a wide dynamic range, high contrast ratio, and high gradation representation, etc.), it is possible to improves display. It is another object of the present invention to improve image display in this way. An invention which achieves the objects will be referred to as AI driving.

For ease of explanation, it is assumed that an IC chip 14 of the present invention is compatible with 64-gradation display. To implement AI driving, it is desirable to extend a range of gradation representation. For ease of explanation, it is assumed that a source driver circuit (IC) 14 of the present invention is compatible with 64-gradation display and that image data consists of 256 gradations. The image data is gamma-converted to suit the gamma characteristics of the EL display apparatus. The gamma conversion expands 256 gradations into 1024 gradations. The gamma-converted image data goes through an error diffusion process or frame rate control (FRC) process to be compatible with the 64-gradation source data and then it is applied to the source driver circuit 14.

If image data of one screen is generally large, the sum total of image data is large as well. Take as an example a white raster in 64-gradation display, since the white raster as image data is represented by 63, the sum total of image data is given by “the pixel count of the display screen 144”×63. In the case of white display with the maximum brightness in 1/100 of the screen, the sum total of image data is given by “the pixel count of the display screen 144”× 1/100×63.

The present invention determines the sum total of image data or a value which allows the current consumption of the screen to be estimated, and performs duty cycle control or reference current control using the sum total or the value.

Incidentally, although the sum total of image data is determined above, this is not restrictive. For example, an average level of one frame of image data may be determined and used. In the case of an analog signal, the average level can be determined by filtering the analog image signal with a capacitor. Alternatively, it is possible to extract a direct current level from the analog image signal through a filter, subject the direct current level to A/D conversion, and use the result as the sum total of image data. In this case the image data may be referred to as an APL level.

It is preferable to determine the sum total of image data for 30 to 300 frame periods or data which allows the sum total to be estimated and perform duty ratio control based on the value of the data. The sum total of data changes slowly along with changes in the images. The larger the number of frame periods used to sum the data, the more slowly the brightness of the images changes.

There is no need to add all the data composing an image on the display screen 144. It is possible to pick up 1/W (w is larger than 1) of data on the display screen 144 and determine the sum total of the data picked up. Possible methods include, for example, a method which samples video data of every other pixel and sums the sampled video data as well as a method which samples video data of each pixel row or few pixel rows and sums the sampled video data.

For ease of explanation, it is assumed in the above case that the sum total of image data is determined. Calculation of the sum total of image data is often tantamount to determining the APL level of the image. Also, means of adding the sum total of image data digitally is available, and the above-mentioned methods of determining the sum total of image in a digital or analog fashion will be referred to as an APL level hereinafter for ease of explanation.

In the case of a white raster, since an image consists of 6 bits each of R, G, and B, the APL level is given by 63×pixel count (where 63 represents the data, which corresponds to the 63^{rd} gradation, and the pixel count of a QCIF panel is 176×RGB×220). Thus, the APL level reaches its maximum. However, since the current consumption of the EL elements 15 vary among R, G, and B, preferably the image data should be calculated separately for R, G, and B.

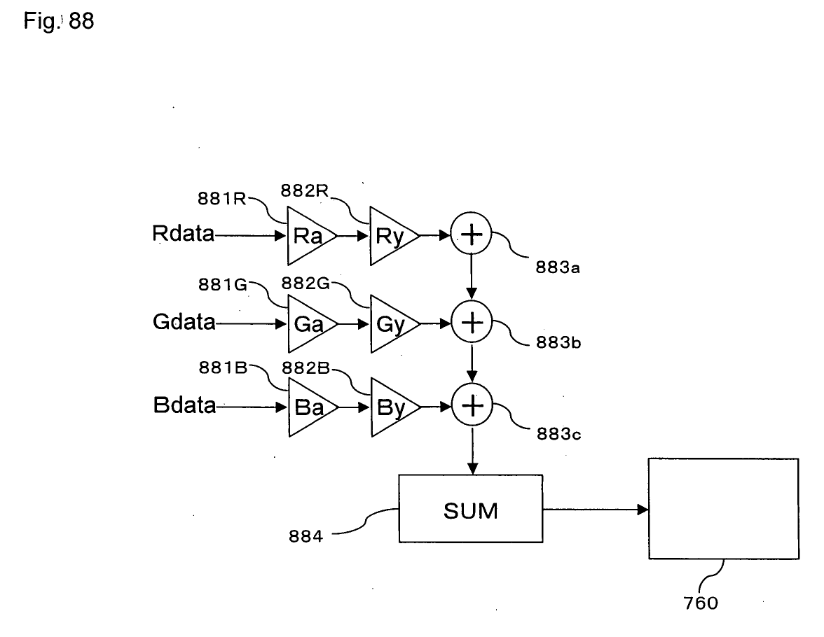

To solve the above problem, an arithmetic circuit shown in FIG. 88 is used. In FIG. 88, reference numerals 881 and 882 denote multipliers, of which 881 is a multiplier used to weight emission brightness. Luminosity varies among R, G, and B. The ratio of NTSC-based luminosity among R, G, and B is R : G : B=3:6:1. Thus, the multiplier 881R for R multiplies R image data (Rdata) by 3, multiplier 881G for G multiplies G image data (Gdata) by 6, and multiplier 881B for B multiplies B image data (Bdata) by 1. However, this description is conceptualized and actually efficiency of the EL elements 15 vary among R, G, and B.

The light emission efficiency of the EL elements 15 varies among R, G, and B. The light emission efficiency of B is the lowest. The light emission efficiency of G is the next lowest. The light emission efficiency of R is good. Thus, the multipliers 882 weight data by the luminous efficiencies. The multiplier 882R for R multiplies the R image data (Rdata) by the light emission efficiency of R. Also, multiplier 882G for G multiplies the G image data (Gdata) by the light emission efficiency of G, and multiplier 882B for B multiplies the B image data (Bdata) by the light emission efficiency of B.

The results produced by the multipliers 881 and 882 are added by an adder 883 and stored in a summation circuit 884. Then, the reference current control and duty cycle control are performed based on the results produced by the summation circuit 884.

In the above example, data is obtained by multiplying video data by a predetermined value, taking into consideration the efficiency of the EL elements 15. The present invention determines the current flowing through the anode or cathode terminal of the display panel, based on the video data.

Normally, R, G, and B EL elements 15 have known efficiency according to EL material, and thus there is a known relationship between current and brightness. Also, target color temperatures have been established for EL display panels during production. Consequently, once the display size and target brightness of a display panel are determined, it is possible to know the magnitudes of R, G, and B currents and ratios among them needed to reach the target color temperature. Thus, by setting the current passed through the anode or cathode terminal of the display panel to a predetermined value, it is possible to obtain the target brightness and color temperature.

The current flowing through the anode or cathode terminal is proportional to the sum total of video data. Thus, the anode current (cathode current) can be determined from the sum total of video data. The anode current is the current flowing into the anode terminal connected to the display area. The cathode current is the current flowing out of the cathode terminal connected to the display area. Since the anode voltage and cathode voltage have fixed values, the power consumption of the EL display panel can be controlled based on the video data.

That is, by monitoring (operating on) the magnitude or changes in the magnitude of (the sum total of) video data, it is possible to determine the cathode (anode) current needed for the EL display panel. If it is known how to reduce the current, the magnitude of the current can be controlled by reference current control or duty ratio control.

Of course, if the magnitude of the anode current or cathode current is subjected to A/D (analog/digital) conversion, the magnitude of the current can be controlled by reference current control or duty ratio control based on the resulting digital data. Also, if amplification factors of operational amplifiers are subjected to feedback control using analog data directly, the magnitude of the current can be controlled by reference current control or duty ratio control. That is, control methods are available for use regardless of whether they are digital or analog.

Thus, the present invention calculates or controls the power (current) consumed by the EL display panel based on the magnitude of video data (or data proportional to it) (or based on data which allows the magnitude to be estimated), and thereby performs duty ratio control or reference current control.

When calculating the power (current) consumed by the EL display panel based on the magnitude of video data (or data proportional to it) (or based on data which allows the magnitude to be estimated), the calculations may be carried out not only for each frame (field), but also for multiple frames (fields) at once or for each frame (field) multiple times. Besides, the reference current control or duty ratio control may be performed not only in real time. Needless to say, the control may be performed with some delay, with some hysteresis, or by skipping.

Although it has been stated that the magnitude of the anode current or cathode current of the EL display panel is placed under reference current control or duty ratio control, this is not restrictive. Needless to say, the power consumption of the EL display panel can be controlled by controlling the anode voltage or cathode voltage.

The method in FIG. 88 allows a luminance signal (Y signal) to be subjected to duty cycle control and reference current control. However, duty control based on detection of the luminance signal (Y signal) may involve problems. For example, a blue back screen is a case in point. For a blue back screen, the EL display panel consumes relatively large current. However, display brightness is low because of low luminosity of blue (B). Consequently, the sum total (APL level) of the luminance signal (Y signal) is calculated to be smaller, resulting in a high duty ratio. This causes flickering and the like.

To deal with this problem, it is recommendable to use the multipliers 881 in a pass-through mode. This makes it possible to find the sum total (APL level) based on current consumption. It is desirable to determine both the sum total (APL level) based on the luminance signal (Y signal) and sum total (APL level) based on current consumption and find a consolidated APL level taking both of them into consideration. Then, the duty cycle control, reference current control and precharge control should be performed based on the consolidated APL level.

A black raster corresponds to the 0th gradation in the case of 64-gradation display, and thus the minimum APL level is 0. In current driving, power consumption (current consumption) is proportional to image data. Regarding image data, there is no need to count all the bits in the data on the display screen 144. For example, if an image consists of 6-bit data, only the most significant bit (MSB) may be counted. In this case, 33 gradations are counted as 1. Thus, the APL level varies with the image data on the display screen 144. Thus, the sum total of image data does not have to be a complete sum total and may be any variable which allows the sum total to be estimated.

As the sum total of video data or as an index analogous to the sum total, the term “APL level” is used from an analog standpoint. However, the drive method according to the present invention is described using the term “lighting ratio” in the latter half of this specification. Incidentally, the lighting ratio will be described later.

For ease of understanding, description will be given citing concrete figures. However, this is virtual. In actual practice, control data and control directions must be determined through experiments and image evaluations.

Let us assume that the maximum current that can flow through an EL display panel is 100 mA, that the sum total (APL level) in white raster display is 200 (no unit), and that a current of 200 mA will flow through the EL display panel if the APL level of 200 is applied directly to the panel. Incidentally, when the APL level is 0, a zero (0 mA) current flows through the EL panel. Also, it is assumed that when the APL level is 100, the duty ratio is ½.

Thus, when the APL level is 100 or above, it is necessary to limit the current to 100 mA or below. The simplest way is to set the duty ratio to ½×½=¼ when the APL level is 200 and set the duty ratio to ½ when the APL level is 100. When the APL level is between 100 and 200, the duty ratio should be controlled so as to fall within a range of ¼ to ½. The duty ratio can be kept between ¼and ½by controlling the number of gate signal lines 17b selected simultaneously by the EL-selection-side gate driver circuit 12b.

However, if duty cycle control is performed considering only the APL level, in accordance with the image not in accordance with the average brightness (APL) of the display screen 144 the brightness of the display screen 144 will vary, causing flicker. To solve this problem, the APL level is retained for a period of at least 2 frames, preferably 10 frames, or more preferably 60 frames, and the duty ratio for duty cycle control is calculated using the data retained for this period. Also, it is preferable to extract characteristics of the display screen 144 including its maximum brightness (MAX), minimum brightness (MIN), and brightness distribution (SGM) for use in the duty cycle control. Needless to say, the above items are also applicable to reference current control.

Also, it is important to do black stretching and white stretching based on the extracted image characteristics. Preferably, this is done taking into consideration the maximum brightness (MAX), minimum brightness (MIN), brightness distribution (SGM) and changing condition of scenes. Thus, in addition to simply calculating the sum total (APL level or lighting ratio) by addition of video data, it is preferable to correct the sum total by taking into consideration the distribution of image display, etc. Available circuit configurations include, for example, the configuration used to add the amounts of correction in a correction circuit (not shown) of the adder 883c in FIG. 88.

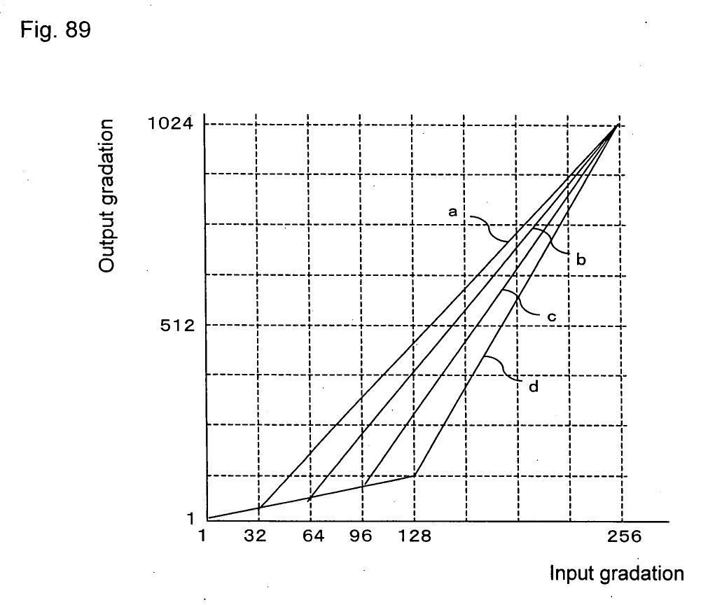

Although it has been stated that the gamma circuit 854 performs a gamma process using multi-point polygonal gamma curves, this is not restrictive. Single-point polygonal gamma curves may be used for the gamma correction as shown in FIG. 89. Since hardware needed to generate single-point polygonal gamma curves is small in scale, costs of control ICs can be reduced.

Referring to FIG. 89, curve a represents polygonal gamma conversion in the 32nd gradation, curve b represents polygonal gamma conversion in the 64th gradation, curve c represents polygonal gamma conversion in the 96th gradation, and curve d represents polygonal gamma conversion in the 128th gradation. If image data are concentrated in high gradations, gamma curve d in FIG. 89 should be selected to increase the number of high gradations. If image data are concentrated in low gradations, gamma curve a in FIG. 89 should be selected to increase the number of low gradations. If image data are scattered, gamma curve b or c in FIG. 89 should be selected. Incidentally, although it has been stated in the above example that a gamma curve is selected, actually the gamma curve is generated by arithmetic operations rather than being selected.

Gamma curves are selected by taking into consideration the APL level, maximum brightness (MAX), minimum brightness (MIN), and brightness distribution (SGM). Also, duty cycle control and reference current control should be taken into consideration.

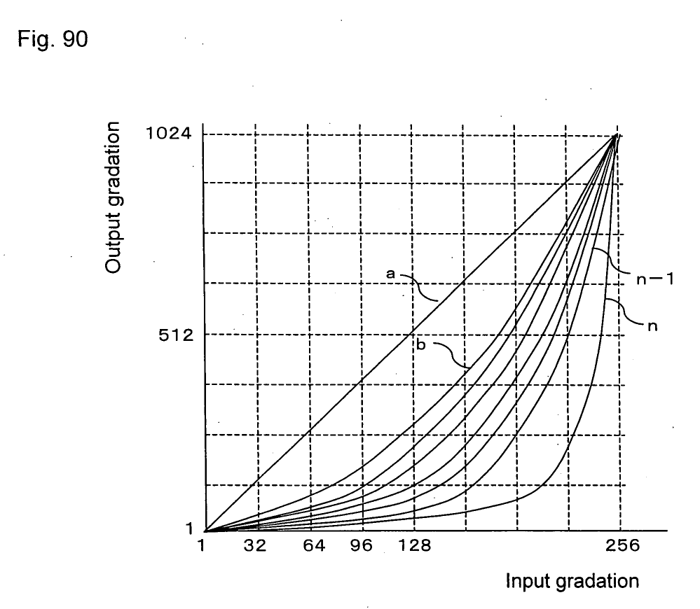

FIG. 90 shows an example of multi-point polygonal gamma curves. If image data are concentrated in high gradations, gamma curve n in FIG. 89 should be selected to increase the number of high gradations. If image data are concentrated in low gradations, gamma curve a in FIG. 89 should be selected to increase the number of low gradations. If image data are scattered, gamma curves b to n−1 in FIG. 89 should be selected. The gamma curves are selected by taking into consideration the APL level, maximum brightness (MAX), minimum brightness (MIN), brightness distribution (SGM), variation ratio of scenes, variation amount of scenes, and content of scenes. Also, duty cycle control and reference current control should be taken into consideration.

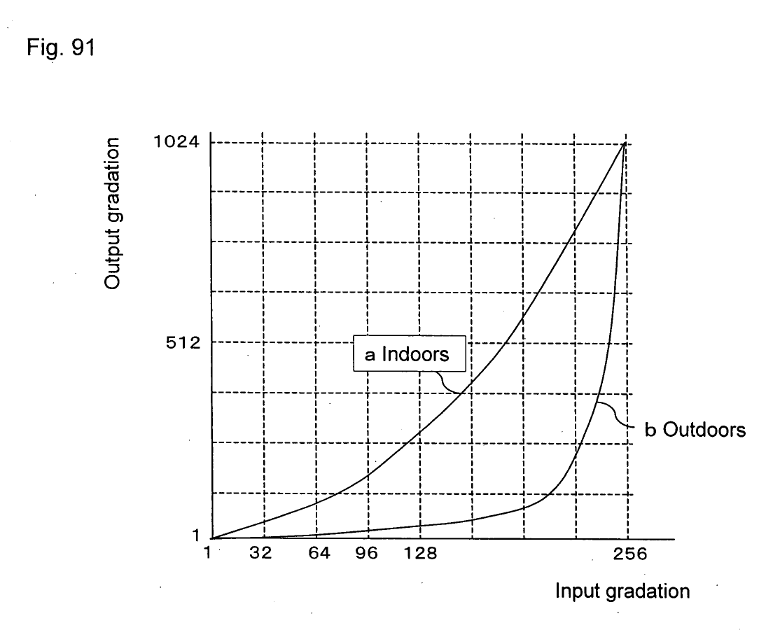

It is also useful to vary gamma curves according to environment in which the display panel (display apparatus) is used. EL display panels, in particular, achieve proper image display, but do not provide visibility in low gradation part when used outdoors. This is because the EL display panels are self-luminous. So gamma curves may be varied as shown in FIG. 91. Gamma curve a is for indoor use while gamma curve b is for outdoor use. To switch between gamma curves a and b, the user operates a switch. Also, the gamma curves may be switched automatically by a photosensor which detects the brightness of extraneous light.

Incidentally, although it has been stated that a gamma curves are switched, this is not restrictive. Needless to say, a gamma curve may be generated by calculation. In outdoor use, low gradation display part is not visible because of bright extraneous light. Thus, it is useful to select gamma curve b which suppresses the low gradation display part.

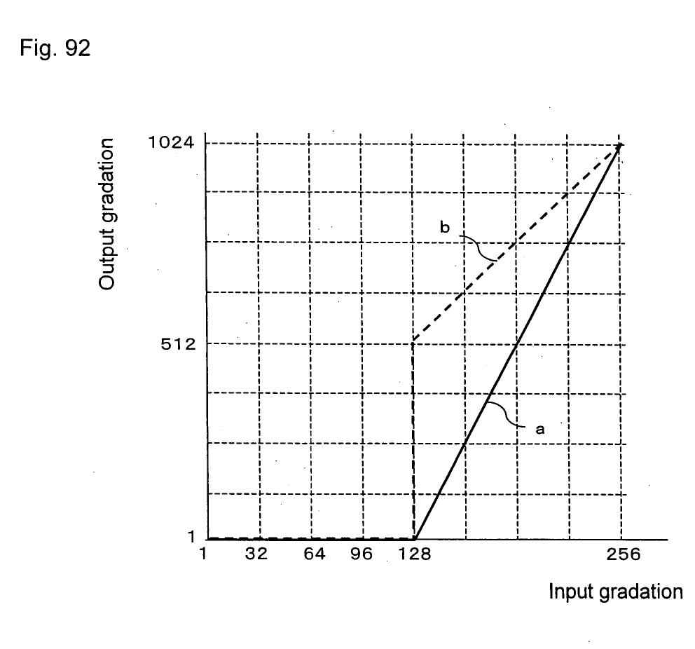

In outdoor use, it is useful to generate gamma curves in the manner shown in FIG. 92. Output gradation of gamma curve a is set to 0 up to the 128th gradation. Gamma conversion is carried out beginning with the 128th gradation. In this way, by performing gamma conversion so as not to display low gradation part at all, it is possible to reduce power consumption. Also, gamma conversion may be performed in the manner indicated by gamma curve b in FIG. 92. Output gradation of the gamma curve in FIG. 92 is set to 0 up to the 128th gradation. Then, beginning with the 128th gradation, output gradation is set to 512 or higher. Gamma curve b in FIG. 92 displays high gradation part, reduces the number of output gradations, and thereby makes image display easy to view.

The drive method according to the present invention uses duty cycle control and reference current control to control image brightness and extend a dynamic range. Also, it achieves high-current display.

In liquid crystal display panels, white display and black display are determined by transmission of a backlight. Even if a non-display area 192 is generated on the display screen 144 as in the case of the duty ratio driving according to the present invention, transmittance during black display is constant. Conversely, when a non-display area 192 is generated, white display brightness during one frame period lowers, resulting in reduced display contrast.

In EL display panels, zero (0) current (current does not flows or is minute) flows through the EL elements 15 during black display. Thus, even if a non-display area 192 is generated on the display screen 144 as in the case of the duty ratio driving according to the present invention, transmittance during black display is 0. A large non-display area 192 lowers white display brightness. However, since the brightness of black display is 0, the contrast is infinite. Thus, the duty ratio driving is the most suitable drive method for EL display panels. The above items also apply to reference current control. Even if the magnitude of reference current is changed, the brightness of black display is 0. A large reference current increases white display brightness. The reference current control also achieves proper image display.

Duty cycle control maintains the number of gradations and white balance over the entire range of gradations. Also, the duty cycle control allows the brightness of the display screen 144 to be changed nearly ten-hold. Also, the change has a linear relationship with the duty ratio, and thus can be controlled easily. However, the duty cycle control is N-pulse driving, which means that large currents flow through the EL elements 15. Since large currents always flow through the EL elements regardless of the brightness of the display screen 144, the EL elements 15 are prone to degradation.

Reference current control increases the amounts of reference current to increase screen brightness 144. Thus, large currents flow through the EL elements 15 only when the display screen 144 is bright. Consequently, the EL elements 15 are less prone to degradation. A problem with the reference current control is that it tends to be difficult to maintain white balance when the reference current is varied.

The present invention uses both reference current control and duty cycle control. Needless to say, only one of them may be varied with the other fixed. When the display screen 144 is close to white raster display, display brightness and the like are controlled by varying the duty ratio with reference currents set to fixed values. When the display screen 144 is close to black raster display, display brightness and the like are controlled by varying the reference currents with the duty ratio set to a fixed value. Of course, it is alternatively possible to reduce the duty ratio, increase the reference currents, and increase the programming currents Iw with the display brightness kept constant.

The duty cycle control is performed when the lighting ratio is between 1/10 and 1/1, inclusive. If the duty ratio is 1/1 during white raster display, the lighting ratio is 100% (during maximum white raster display). In black raster, the lighting ratio is 0% (during complete black raster display).

The lighting ratio is also a ratio to the maximum current which can flow through the anode or cathode of the panel (assuming that the duty ratio is 1/1). For example, if the maximum current which can flow through the cathode is 100 mA and a current of 30 mA is flowing at a duty ratio of 1/1, zsxdd is 30% or 0.3 (= 30/100). In the pixel configuration in FIG. 1, etc., when calculating the lighting ratio, it is necessary to take into consideration the fact that programming current is added to the anode current. On the other hand, only the current consumed by the EL element flows through the cathode. Thus, when calculating the total current consumed by the EL elements 15 of the EL display panel, it is more preferable to measure the current flowing through the cathode terminal.

If the maximum current which can flow through the cathode is 100 mA and the sum total of video data reaches its maximum value at the maximum current, the lighting ratio is synonymous with SUM control or APL control. The term “lighting ratio” will be mainly used hereinafter because its use makes it easier to understand magnitudes, with a lighting ratio of 50% meaning that current flowing through the cathode (anode) is 50% the maximum current and a lighting ratio of 20% meaning that the current flowing through the cathode (anode) is 20% the maximum current. The maximum value of the current flowing through the cathode (anode) terminal is the maximum current which can flow through the terminal in terms of design, and it is a relative value. For example, the maximum value is small if the design value is small.

It has been stated that the lighting ratio is a ratio to the maximum current which can flow through the anode or cathode of the panel, and it can be restated that the lighting ratio is a ratio to the maximum current which can flow through all the EL elements 15.

When dealing with the lighting ratio herein, it is assumed that the duty ratio is 1/1 unless otherwise stated. If a current of 20 mA flows at a duty ratio of ⅓, the lighting ratio is 60% or 0.6 (=20 mA× 3/100 mA). That is, even if the lighting ratio is 100%, the current flowing through the anode (cathode) terminal is ½ the maximum current if the duty ratio is ½. If an anode current of 20 mA flows at a lighting ratio of 50% and a duty ratio of 1/1, an anode current of 10 mA flows at a duty ratio of ½. If an anode current of 100 mA flows at a lighting ratio of 40% and a duty ratio of 1/1, when the anode current changes to 200 mA, the lighting ratio changes to 80%. In this way, the lighting ratio represents a ratio to the video data composing one screen or represents the current (power) consumption of the EL display panel or its ratio.

Needless to say, the above items apply not only to EL display panels or apparatus with the pixel configuration in FIG. 1, but also to EL display panels or EL display apparatus with another pixel configuration such as those shown in FIGS. 2, 7, 11, 12, 13, 28, 31, etc.

It goes without saying that reference current control and duty ratio control based on the lighting ratio is applicable not only to EL display panels, but also to any self-luminous display panel such as a FED display panel.

For example, the lighting ratio (lighting ratio) is determined from the sum of video data, i.e., it is calculated from the video data. If input video signals are constituted of Y, U, and V, the lighting ratio may be determined from the Y (luminance) signal. However, in the case of EL display panels, luminous efficiency varies among R, G, and B, and thus the value determined from the Y signal does not corresponds to power consumption. Thus, even when using Y, U, and V signals, preferably they are converted into R, G, and B signals once and they are multiplied by conversion coefficients specific to R, G, and B before determining current consumption (power consumption). However, the ease of circuit processing provided if current consumption is determined from the Y signal in a simplified way is worth considering.

It is assumed that the lighting ratio is understood in terms of current flowing through the panel. This is because EL display panels have a low luminous efficiency for B and a display of the sea or the like will increase power consumption at a stroke. Thus, the maximum value is the maximum power supply capacity. Also, the sum of data is not simply the additional value of video data, but it is video data expressed in terms of current consumption. Thus, the lighting ratio is determined from the ratio of the current used by each image to the maximum current.

For ease of explanation, it is assumed here that the maximum value of the duty ratio is 1/1. It is assumed that the magnification of reference current is varied from 1 to 3 times. The sum of data is the sum total of the data on the display screen 144. The maximum value (of the sum of data) is the sum total of image data in white raster display. Needless to say, there is no need to use the duty ratio of 1/1. The duty ratio of 1/1 is cited here as the maximum value. It goes without saying that the drive method according to the present invention may set the maximum duty ratio to 210/220 or the like. Incidentally, 220 is cited as an example of the number of pixel rows in a QCIF+display panel.

When the duty ratio is 1/1, a lighting ratio of 0% means that N-fold pulse driving is not used. This is because the duty ratio of 1/1 corresponds to the maximum brightness display and there is no need to improve writing of programming current by N-fold pulse driving. When the lighting ratio approaches 100%, decreases in the duty ratio (increases in the value n of the duty ratio =1/n) do not help improve the writing of programming current at all. The duty ratio is decreased only to reduce the power consumption of the panel. This can be understood easily because N-fold pulse driving does not assume a duty ratio of 1/1. The present invention increases the brightness of the screen by increasing the reference currents to above 1 when the lighting ratio is low (when the duty ratio approaches 1/1). This also indicates that the use of N-fold pulse driving is not appropriate.

Preferably, the maximum value of the duty ratio is 1/1and the minimum value is no smaller than 1/16. More preferably, the minimum value is no smaller than 1/10 to reduce flickering. Preferably, a variable range of the reference current is no larger than 4 times. More preferably, it is no larger than 2.5 times. Too large a magnification of the reference current will make the reference current generator circuit loose linearity, causing deviations in the white balance.

A lighting ratio of 1%, for example, corresponds to a 1/100 white window display (duty ratio= 1/1). In the case of natural images, this means a state in which the sum of pixel data used for image display is equivalent to 1/100 of a white raster display. Thus, one white luminescent spot in 100 pixels is also an example in which the lighting ratio equals 1%.

Although it is described below that the maximum value is the sum of image data of a white raster, this is for ease of explanation. The maximum value is produced by an addition process or APL process of image data. Thus, the lighting ratio is a ratio to the maximum value of the image data of the image to be processed.

The sum of data may be calculated using either current consumption or brightness. Addition of brightness (image data) will be cited here for ease of explanation. Generally, addition of brightness (image data) is easier to process and can reduce the scale of controller IC hardware. Also, this method is free of flickering caused by duty cycle control and can provide a wide dynamic range.

Here, a description will be given by mainly referring to FIGS. 93 to 116 as to the driving method of the EL display apparatus wherein the pixels are formed like a matrix, the lighting rate and so on are acquired from the size of the video signal applied to the EL display apparatus, and the passing current is controlled according to the lighting rate and so on.

FIG. 93 shows an example obtained as a result of the reference current control and duty cycle control according to the present invention. In FIG. 93, the magnification of reference current is varied up to 3 times when the ratio of total data to the maximum value is 1/100 or less. The duty ratio is varied from 1/1 to ⅛ when the lighting ratio is 1% or more. Thus, by a value of lighting ratio, the duty ratio is varied 8 times and the reference current is varied 3 times for a total of 24-fold changes (8×3=24). Since both reference current control and duty cycle control vary screen brightness, a 24 times larger dynamic range is obtained.

In FIG. 93, when the lighting ratio is 100%, the duty ratio is ⅛. Thus, the display brightness is ⅛ the maximum value. The lighting ratio equals 100%, which means white raster display. That is, during white raster display, the display brightness is reduced to ⅛ the maximum value. An image display area 193 makes up ⅛ of the display screen 144 while a non-display area 192 makes up ⅞ of the display screen 144. In an image with the lighting ratio being close to 100%, most of the pixels 16 represent high gradations. In terms of a histogram, most of the data are distributed in a high gradation region. In this image display, the image is subject to blooming and lacks contrast. Thus, gamma curve n or similar curve in FIG. 86 is selected. To be more specific, the gamma curve is dynamically changed according to the value of the lighting rate.

When the lighting ratio is 1%, the duty ratio is 1/1. The display screen 144 is occupied by a display area 193. Therefore, screen luminance control by duty ratio control is not performed. The emission brightness of the EL elements 15 becomes the display brightness of the display screen 144 directly. The screen presents almost black display with images displayed only in some part. If represented by an image, the image display at the lighting rate of 1 percent is the image of a pitch-dark sky with stars. In this display, if the duty ratio is changed to 1/1, the part which corresponds to the star is displayed at 8 times the brightness of a white raster. This makes it possible to achieve an image display with a wide dynamic range. Since only 1/100 of the area is used for image display, even if the brightness of this area is increased 8-fold, the increase in power consumption is marginal. The reference current is increased at the lighting rate of 1 percent or less. For instance, the reference current ratio is 2 at the lighting rate of 0.1 percent. Therefore, it is displayed at the luminance twice higher than that at the lighting rate of 1 percent. To be more specific, the portions of the stars are displayed at the luminance of 8×2 times the luminance of the white raster of the lighting rate of 100 percent.

As described above, it is possible to increase the luminance of the display pixels by increasing the reference current at a low lighting rate. This process can render the image glossy and implement the image display with a depth feel.

If most of the pixels 16 are displayed at a low gradation in the case of the image of the lighting rate of close to 1 percent, in terms of a histogram, most of the data are distributed in a low gradation region. In this image display, the image is subject to loss of shadow detail and lacks contrast. Thus, gamma curve b or similar curve in FIG. 90 is selected.

Thus, the drive method according to the present invention increases the multiplier×of gamma with increases in the duty ratio, and decreases the multiplier x of gamma with decreases in the duty ratio.

In FIG. 93, when the lighting ratio is 1% or less, the magnification of reference current is varied up to 3 times. When the lighting ratio is 1% or less, the duty ratio is set to 1/1 to increase the screen brightness. As the lighting ratio gets smaller than 1%, the magnification of reference current is increased. Thus, illuminating pixels 16 emits light more brightly. For example, an image display in which the lighting ratio is 0.1% is like a dark night sky in which the stars are out. In this display, if the duty ratio is changed to 1/1, the parts which correspond to the stars are displayed at 16 (=8×2) times the brightness of a white raster. This makes it possible to achieve an image display with a wide dynamic range. Since only 0.1% of the area is used for image display, even if the brightness of this area is increased 16-fold, the increase in power consumption is marginal.

In reference current control, it is difficult to maintain white balance. However, in an image of the dark sky with the stars, even if the white balance is deviated, the deviation is not perceived visually. Thus, the present invention, which performs reference current control in a range where the lighting ratio is very small, provides an appropriate drive method.

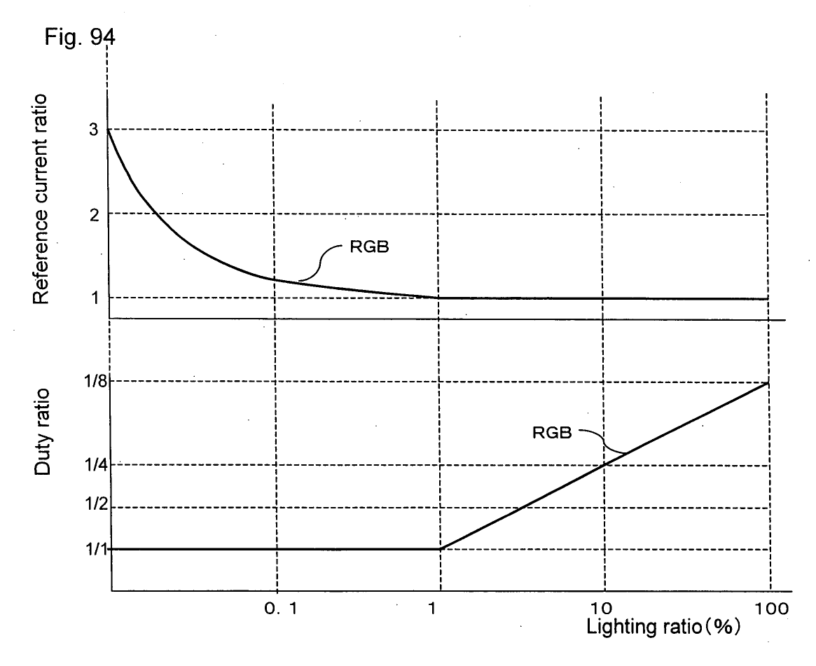

In FIG. 93, changes in the reference current and duty ratio are illustrated linearly. However, the present invention is not limited to this. The magnification of reference current and the duty ratio may be controlled curvilinearly. In FIGS. 94, since the lighting ratio in the horizontal axis is logarithmic, it is natural that the graphs of reference current control and duty cycle control are curvilinear. Preferably, the relationship between the lighting ratio and magnification of reference current as well as the relationship between the lighting ratio and duty cycle control are specified according to contents of image data, display condition of images, and external environment.

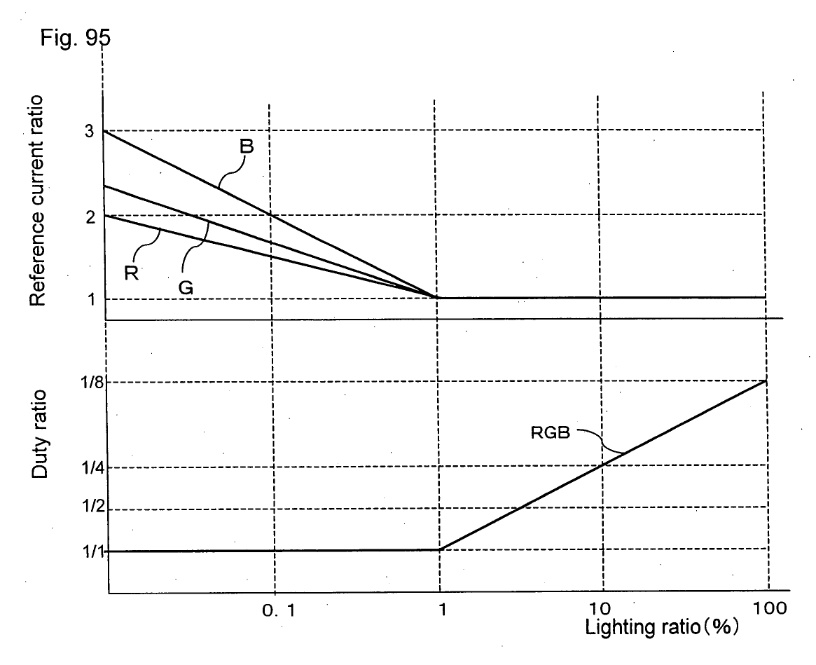

FIGS. 93 and 94 show examples in which common duty cycle control and reference current control are performed for R, G, and B. However, the present invention is not limited to this. As illustrated in FIG. 95 the slope of change in the magnification of reference current may be varied among R, G, and B. In FIG. 95, in which the slope of change in the magnification of reference current for blue (B) is the largest, the slope of change in the magnification of reference current for green (G) is the next largest, and the slope of change in the magnification of reference current for red (R) is the smallest. A large reference current increases the current flowing through the EL element 15. The light emission efficiency of the EL elements 15 varies among R, G, and B. A large current flowing through the EL element lowers light emission efficiency relative to applied current. This tendency is noticeable especially in the case of B. Consequently, white balance is upset unless the amounts of reference current are adjusted among R, G, and B. Thus, as shown in FIG. 95, if the magnification of reference current is increased (in an area where large currents flow through the EL elements 15 of R, G, and B), it is useful to vary the magnification of reference current among R, G, and B so that the white balance can be maintained. Preferably, the relationship between the lighting ratio and magnification of reference current as well as the relationship between the lighting ratio and duty cycle control are specified according to contents of image data, display condition of images, and external environment.

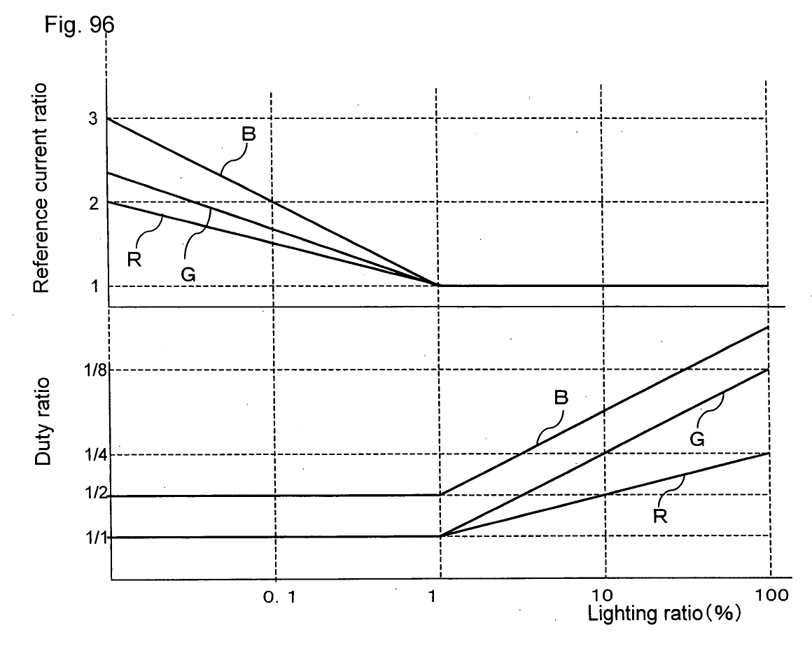

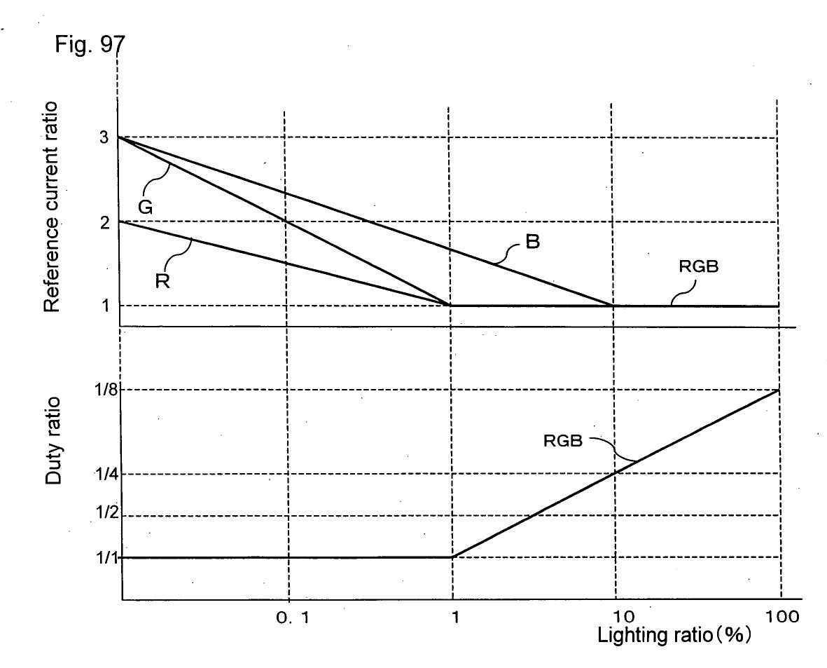

FIG. 95 has been an example in which the magnification of reference current is varied among R, G, and B. In FIG. 96, duty cycle control is varied as well. When the lighting ratio is 1% or more, B and G have the same slope while R has a smaller slope. When the lighting ratio is 1% or less, G and R have a duty ratio of 1/1while B has a duty ratio of ½. In FIG. 96, the reference currents are also different. At the lighting rate of 1 percent or less, the inclination of B is the largest while the inclination of R is the smallest. This drive (control) method can optimize the RGB white balance. Preferably, the relationship between the lighting ratio and magnification of reference current as well as the relationship between the lighting ratio and duty cycle control are specified according to contents of image data, display condition of images, and external environment. Also, it is preferable that they can be set or adjusted freely by the user.

In FIGS. 93 to 96, either the magnification of reference current or the duty ratio is varied depending on whether the lighting ratio is below or above 1%, as an example. Either the magnification of reference current or the duty ratio is varied depending on whether the lighting ratio takes a certain value so that the area in which the magnification of reference current is varied and the area in which the duty ratio is varied will not overlap. This makes it easy to maintain white balance. Specifically, the duty ratio is varied when the lighting ratio is larger than 1% and the reference current is varied when the lighting ratio is smaller than 1% so that the area in which the magnification of reference current is varied and the area in which the duty ratio is varied will not overlap. This method is characteristic of the present invention.

The duty ratio is changed at the lighting rate of 1 percent or more while the reference current is changed at the lighting rate of 1 percent or less. However, the relation may be reverse. For instance, it is also possible to change the duty ratio at the lighting rate of 1 percent or less and change the reference current at the lighting rate of 1 percent or more. It is further possible to change the duty ratio at the lighting rate of 1 percent or more, change the reference current at the lighting rate of 1 percent or less, and render the reference current multiplying factor and the duty ratio as constant values at the lighting rate of 1 percent to 10 percent.

In some cases, the present invention is not limited to the above methods. As illustrated in FIG. 97, the duty ratio may be varied when the lighting ratio is larger than 1% and the reference current for B may be varied when the lighting ratio is smaller than 10%. Changes in the reference current for B and changes in the duty ratio for R, G, and B are overlapped.

If a bright screen and dark screen alternate quickly and the duty ratio is varied accordingly, flicker occurs. Thus, when the duty ratio is changed from one value to another, preferably hysteresis (time delay) is provided. For example, if a hysteresis period is 1 sec., even if the screen changes its brightness a plurality of times within the period of 1 sec., the previous duty ratio is maintained. That is, the duty ratio does not change. The hysteresis time (time delay) is referred to as a Wait time. Also, the duty ratio before the change is referred to as a pre-change duty ratio and the duty ratio after the change is referred to as a post-change duty ratio.

If a small pre-change duty ratio changes its value, the change tends to cause flicker. A small pre-change duty ratio means a small sum of display screen 144 data or a large black display part on the display screen 144. Maybe the display screen 144 presents intermediate gradations, resulting in high luminosity. Also, in an area with a small duty ratio, difference between pre-change and post-change duty ratios tends to be large. Of course, if there is a large difference of duty ratios, an OEV2 terminal should be used for control. However, there is a limit to OEV2 control. In view of the above circumstances, the wait time should be increased when a pre-change duty ratio is small.

If a small pre-change duty ratio changes its value, the change is less prone to cause flicker. A large pre-change duty ratio means a large sum of display screen 144 data or a large white display part on the display screen 144. May be the entire display screen 144 presents a white display, resulting in low luminosity. In view of the above circumstances, the wait time may be short when a pre-change duty ratio is large.

The above relationship is shown in FIG. 94. The horizontal axis represents the pre-change duty ratio and the vertical axis represents the Wait time (seconds). When the duty ratio is 1/16 or less, the Wait time is as long as 3 seconds. When the duty ratio is between 1/16 and 8/16(=½), the Wait time is varied between 3 seconds and 2 seconds depending on the duty ratio. When the duty ratio is between 8/16 and 16/16(= 1/1), the Wait time is varied between 2 seconds and 0 seconds depending on the duty ratio.

In this way, the duty cycle control according to the present invention varies the Wait time with the duty ratio. When the duty ratio is small, the Wait time is increased and when the duty ratio is large, the Wait time is decreased. That is, in a drive method which varies at least the duty ratio, a first pre-change duty ratio is smaller than a second pre-change duty ratio and the Wait time for the first pre-change duty ratio is set longer than the Wait time for the second pre-change duty ratio.

In the above example, the Wait time is controlled or prescribed based on the pre-change duty ratio. However, there is only a small difference between pre-change duty ratio and post-change duty ratio. Thus, in the above example, the term “pre-change duty ratio” may be replaced with the term “post-change duty ratio.”

The above example has been described based on pre-change and post-change duty ratios. Needless to say, the Wait time is increased when there is a large difference between pre-change and post-change duty ratios. Also, it goes without saying that when there is a large duty ratio difference, an intermediate duty ratio should be provided between the pre-change and post-change duty ratios.

The duty cycle control method according to the present invention provides a long Wait time when there is a large difference between pre-change and post-change duty ratios. That is, it varies the Wait time depending on the difference between pre-change and post-change duty ratios. Also, it allows for a long Wait time when there is a large duty ratio difference.

Also, the duty ratio method according to the present invention provides an intermediate duty ratio before a post-change duty ratio when there is a large duty ratio difference.

In the example in FIGS. 93 and 94, common Wait time is used for red (R), green (G), and blue (B). Needless to say, however, the present invention allows the Wait time to be varied among R, G, and B, as illustrated FIG. 98. This is because luminosity varies among R, G, and B. By specifying the Wait time according to luminosity, it is possible to achieve better image display.

In the following description, the maximum value is the added value of the image data on the white raster. This is intended to facilitate the description. The maximum value is the one that arises in the addition and APL processes of the image data. Therefore, the lighting rate is the ratio to the maximum value of the image data on the screen on which the process is performed.

As for the data sum, however, it is not necessary to accurately add the data on one screen. It may be the added value of one screen estimated (predicted) from the added value of the data on the pixels for sampling the one screen. This applies to the maximum value likewise. It may also be a predicted value or an estimate value from multiple fields or multiple frames. It is also possible, apart from addition of the image data, to acquire an APL level of the image data by means of a low-pass filter circuit so as to render the APL level as the data sum. The maximum value in this case is the maximum value of the APL level when the video data of maximum amplitude is inputted.

The data sum may be computed either based on a consumption current of a display panel or based on the luminance. To facilitate the description, it will be described as the addition of the luminance (image data). In general, the process is easier by the method of the addition of the luminance (image data).

FIG. 99 has its horizontal axis as the lighting rate. The maximum value is 100 percent. Its vertical axis is the duty ratio. If the lighting rate=100 percent, all the pixel lines are in a maximum white display state. When the lighting rate is low, the screen is dark or has a little display (lit-up) area. In that case, the duty ratio is high. Therefore, the luminance of the pixels displaying the image is high. For that reason, a dynamic range of the image is expanded and displayed in high image quality. When the lighting rate is high (maximum value is 100 percent), the screen is bright or has a large display (lit-up) area. In that case, the duty ratio is low. Therefore, the luminance of the pixels displaying the image is low. For that reason, it is possible to reduce power consumption. As the amount of light radiated from the screen is large, the image does not feel dark.

In FIG. 99, the duty ratio value to be reached is changed when the lighting rate is 100 percent. For instance, if the duty ratio=½, ½ of the screen is in an image display state. Therefore, the image is bright. If the duty ratio=⅛, ⅛ of the screen is in an image display state. Therefore, it is the brightness of ¼ compared to the duty ratio=½.

The drive method according to the present invention uses lighting rate, duty ratio and reference current, data sum and so on to control image brightness and extend a dynamic range. Also, it achieves high-current display.

In liquid crystal display panels, white display and black display are determined by transmission of a backlight. Even if a non-display area is generated on the screen as in the case of the driving method according to the present invention, transmittance during black display is constant. Conversely, when a non-display area is generated, white display brightness during one frame period lowers, resulting in reduced display contrast.

In EL display panels, zero (0) current flows through the EL elements during black display. Thus, even if a non-display area 52 is generated on the screen as in the case of the driving method according to the present invention, transmittance during black display is 0. A large non-display area lowers white display brightness. However, since the brightness of black display is 0, the contrast is infinite. Thus, proper image display can be achieved.

The driving method according to the present invention can maintain the number of gradations and white balance over the entire range of gradations. Also, the duty cycle control allows the brightness of the screen to be changed nearly ten-hold. Also, the change has a linear relationship with the duty ratio, and thus can be controlled easily. It is also possible to change R, G and B at the same ratio. Therefore, the white balance is maintained at any duty ratio.

Preferably, the relationship between lighting rate and duty ratio is specified according to contents of image data, display condition of images, and external environment. Also, it is preferable that they can be set or adjusted freely by the user.

The switching operation described above is used for cell phones, monitors, etc. which display the display screen very brightly at power-on and reduce display brightness after a certain period to save power. To reduce the display luminance, either the duty ratio or the reference current is reduced. One of the duty ratio and the reference current is reduced. It is possible, by reducing the reference current or the duty ratio, to reduce the power consumption of the EL display panel.

The control method described above can also be used to allow the user to set a desired brightness. For example, the brightness of the screen is increased greatly outdoors. This is because the screen cannot be seen at all outdoors due to bright surroundings. Hence, the curve a in FIG. 99 is selected outdoors. However, the EL elements deteriorate quickly under conditions of continuous display at high brightness. Thus, the screen 50 is designed to return to normal brightness in a short period of time if it is displayed very brightly. Normally, the curve c is selected, for instance. A button which can be pressed to increase display brightness should be provided, in case the user wants to display the screen 50 at high brightness again.

Thus, it is preferable that the user can change display brightness with the button, that the display brightness can be changed automatically according to mode settings, or that the display brightness can be changed automatically by detecting the brightness of extraneous light. Preferably, display brightness settings such as 50%, 60%, 80%, etc. are available to the user. It is also desirable to rewrite the duty ratio curve and inclination with an external microcomputer. It is further desirable to be able to select one of multiple duty ratio curves stored in the memory.

Needless to say, it is preferable that duty ratio curves, etc. are selected by taking into consideration any one of or a plurality of the APL level, maximum brightness (MAX), minimum brightness (MIN), and brightness distribution (SGM).

As described above, reference character a is a curve for outdoor use, for instance. Reference character c is a curve for indoor use. Reference character b denotes a curve for an intermediate state between the indoor and outdoor curves. To switch between curves a and b, the user operates a switch. Also, the gamma curves may be switched automatically by a photosensor which detects the brightness of extraneous light. Incidentally, although it has been stated that a gamma curves are switched, this is not restrictive. Needless to say, a gamma curve may be generated by calculation.

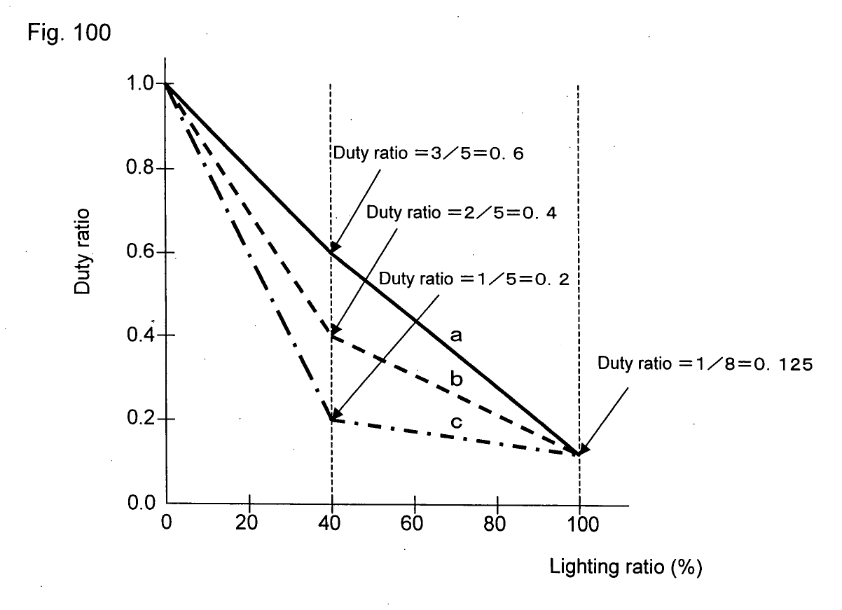

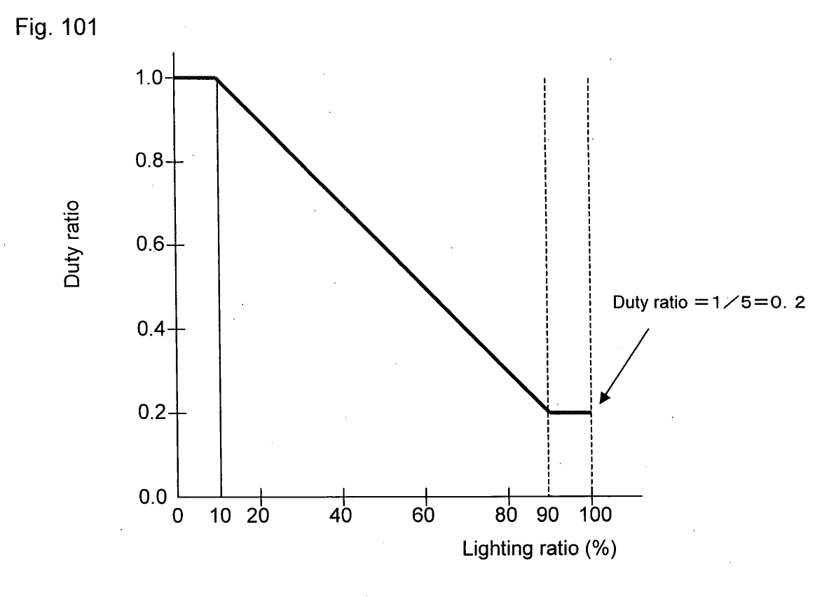

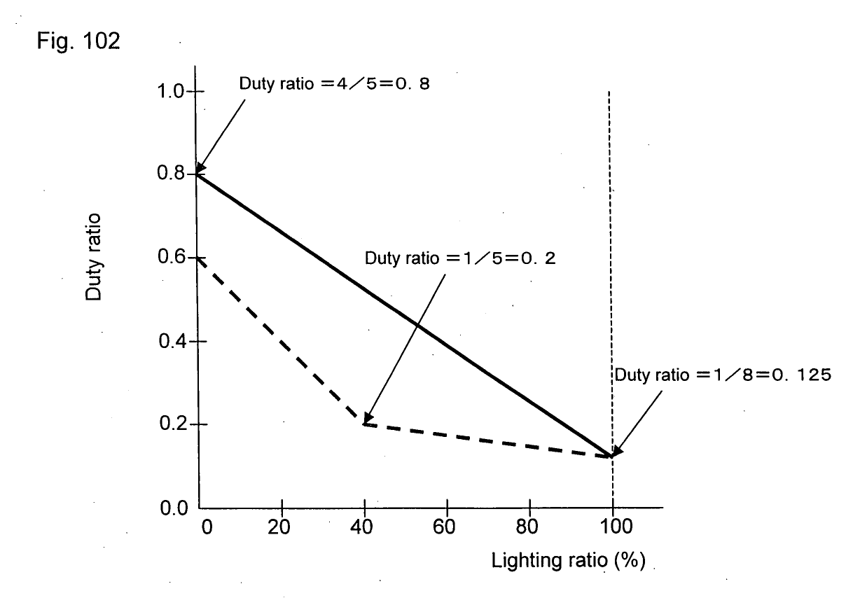

The duty ratio of FIG. 99 is a straight line. However, it is not limited thereto. It may be a curve broken at one point as shown in FIG. 100. To be more specific, the inclination of the duty ratio is changed according to the lighting rate. As a matter of course, the duty ratio curve may be a curving line or a curve broken at multiple points. The duty ratio curve may also be changed in real time according to the outside light or the kind of image. The above applies likewise to change control of the reference current.

In the case where the power consumption of the display panel needs to be reduced, the curve c of FIG. 100 is selected. It is effective in reducing the power consumption. The display luminance is reduced, but the image display such as the number of gradations is not reduced. In the case where the display luminance needs to be high, the curve a of FIG. 100 is selected. The image display becomes brighter, and the flicker occurs less often. The power consumption increases, but the image display such as the number of gradations is not reduced.

According to another embodiment of the present invention, the change of the duty ratio is performed when the lighting rate is equal to 1/10 or more (See FIG. 101). It is because few images of which lighting rate is close to 1 are generated and the image display feels dark if driven to change the duty ratio until the lighting rate becomes 100 as in FIG. 99. More preferably, the change of the duty ratio is performed when the lighting rate is equal to 8/10 or more.

As for natural images, there are many images of which lighting rate is 20 to 40 percent. Therefore, the duty ratio should desirably be large in this range. If the lighting rate is high (60 percent or higher), there is a tendency that the power consumption is high and the EL display panel generates heat and deteriorates. Therefore, it should desirably be controlled so that the duty ratio is 1/1 or in its neighborhood in the range of 20 to 40 percent of the lighting rate or in its neighborhood, and the duty ratio becomes lower than 1/1 at 60 percent of the lighting rate or in its neighborhood.

In FIG. 101, when the lighting rate is 0.9 or less, the duty ratio is changed from 1/1 to ⅕. Thus, a 5 times wide dynamic range is achieved. In FIG. 101, when the lighting rate is 0.9 or more, the duty ratio is ⅕. Thus, the display brightness is ⅕ the maximum brightness value. The lighting rate 100% means white raster display. That is, during white raster display, the display brightness is reduced to ⅕ the maximum brightness value.

If the lighting rate is 10 percent or less, the duty ratio is 1/1. 1/10 of the screen is the display area (in the case of a white window). As a matter of course, it is an image having a lot of dark portions as a natural image. If the duty ratio is 1/1, the light emitting luminance of the EL element becomes the display luminance of the pixels as is because there is no non-lit-up area 192.

The image of which lighting rate is 10% is that the screen presents almost black display with images displayed only in some part. For instance, an image display in which the lighting rate is 10% or less is like a dark night sky in which the moon is out (an example of a referential image for description. 1/10 white window display in the case of the white window). In this display, if the duty ratio is changed to 1/1, the part which corresponds to the moon is displayed at 5 times the brightness of a white raster (brightness at lighting rate 100% in FIG. 101). This makes it possible to achieve an image display with a wide dynamic range. Since only 1/10 of the area is used for image display, even if the brightness of this area is increased 5-fold, the increase in power consumption is marginal.

As described above, the duty ratio is 1/1 or relatively large in the case of the image of which lighting rate is low according to the present invention. At the duty ratio of 1/1, the current is constantly passing through the light emitting pixels. Therefore, the power consumption is high in view of one pixel. However, there are few light emitting pixels on the EL display panel. Therefore, there is little increase in the power consumption in view of the EL display panel as a whole. As for the EL display panel, a black portion is completely black (non-light emitting). Thus, it is possible, if the highest luminance can be displayed at the duty ratio of 1/1, to expand the dynamic range and implement a lively and good image display.

According to the present invention, the image of which lighting rate is high has a relatively small duty ratio such as ⅕. And control is exerted so that the duty ratio becomes smaller according to the lighting rate. When the duty ratio is small, an intermittent current is passing through the light emitting pixels. Therefore, the consumption current of one pixel is small. There are a large number of light emitting pixels on the EL display panel. However, there is little increase in the power consumption in view of the EL display panel as a whole because the power consumption per pixel is little.

As described above, the driving method of the present invention for controlling the duty ratio against the lighting rate is an optimal driving method to a self-luminous display panel such as the EL display panel. As the duty ratio becomes smaller, image luminance becomes smaller. However, it does not give an impression of becoming dark because there are a large number of generated luminous fluxes on the entire screen.

As described above, it is possible, by implementing one or both of the duty ratio control and reference current control, to expand the contrast ratio of the image and have the dynamic range expanded so as to realize reduction in the power consumption.

The control described above is exerted by using the lighting rate. As previously described, the lighting rate is the size of the current flowing into (flowing out of) the anode or cathode in a normal drive (duty ratio: 1/1). If the lighting rate increases, the current of the anode or cathode terminal increases in proportion. The current increases and decreases in proportion to the size of the reference current and also increases and decreases in proportion to the duty ratio. As described above, the present invention is characterized by having the duty ratio and reference current changed by the lighting rate. To be more specific, the duty ratio and reference current are not fixed. They are changed to at least two or more states according to the display state of the image.

In an image with the lighting rate being close to 0, most of the pixels represent low gradations. In terms of a histogram, most of the data are distributed in a low gradation region. In this image display, the image is subject to loss of shadow detail and lacks contrast. For that reason, the gamma curve is controlled to expand the dynamic range of the black display portion.

According to the embodiment, the duty ratio is 1/1 when the lighting rate is 0. However, the present invention is not limited thereto. It goes without saying that the duty ratio may be a value smaller than 1 as shown in FIG. 102. In FIG. 102, the full line indicates the lighting rate 0 and the duty ratio=0.8, and the dotted line indicates the lighting rate 0 and the duty ratio=0.6.

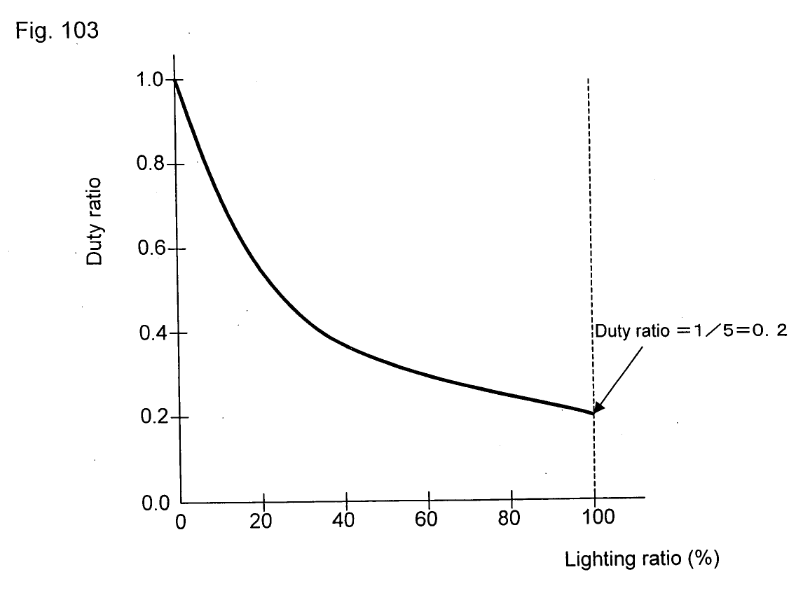

The duty ratio curve may be a curving line as shown in FIG. 103. The curving line is exemplified by a sine curve state, an arc state and a triangular state.

In the case of providing a maximum value to the duty ratio, it is desirable to render it as the maximum value at a certain position in the range of at least the lighting rate of 20 to 50 percent. This range often appears in the image display. Therefore, the duty ratio is rendered larger than the other ranges of the lighting rate such as 1/1, and it is thereby recognized that the image is displayed at high luminance. For instance, a control method is exemplified, whereby the duty ratio is 1/1 at the lighting rate of 35 percent and ½ at the lighting rate of 20 percent and 60 percent.

It is also possible to exert control stepwise according to the lighting rate. A stepwise control method is the method, for instance, whereby the duty ratio is 1/1 at the lighting rate of 0 to 20 percent, ½ at the lighting rate of over 20 percent to 60 percent, and ¼ at the lighting rate of over 60 percent to 100 percent.

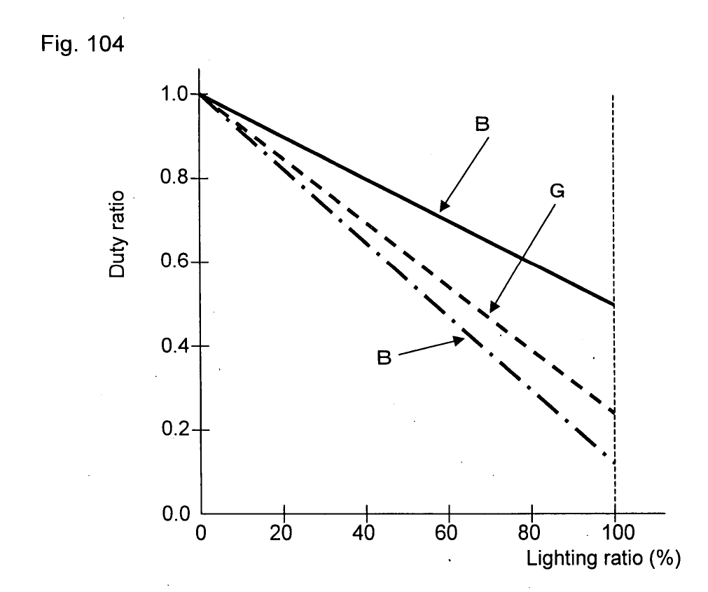

As shown in FIG. 104, it is possible to change the duty ratio curve by the pixels in red (R), green (G) and blue (B). In FIG. 104, the inclination of the change in the duty ratio of blue (B) is the largest, the inclination of the change in the duty ratio of green (G) is the second largest, and the inclination of the change in the duty ratio of red (R) is the smallest. This drive method can optimize the RGB white balance. As a matter of course, it is also possible to exert control to keep one color constant (not changed even if the lighting rate changes) and change the other two colors according to the lighting rate.

Preferably, the relationship between the lighting rate and the duty ratio is specified according to contents of image data, display condition of images, and external environment. Also, it is preferable that they can be set or adjusted freely by the user. It is also desirable to be able to automatically adjust the duty ratio, reference current ratio and so on by the output from the photo sensor or the temperature sensor. For instance, in the case where ambient temperature (panel temperature) is high, it is possible, by lowering the duty ratio (¼ or so), to suppress the consumption current flowing into the panel and thereby lower self heating of the panel so as to consequently reduce the panel temperature. Therefore, it is possible to prevent the panel from deteriorating thermally.

FIG. 444 is a schematic diagram of a temperature detection portion and so on of the display apparatus of the present invention. In FIG. 444, reference numeral 4441 denotes a sheet-like temperature sensor. The temperature sensor 4441 is placed between a back board (a sealing board 40 in FIG. 444) of the panel and a housing (chassis) 1253.

The chassis 1263 is formed by a metal of good thermal conductivity, and a silicone grease of good thermal conductivity is applied between the temperature sensor 4441 and the chassis 1263 and between the sealing board 40 and the temperature sensor 4441. The heat generated from an array board 30 is, by the silicone grease, conducted to the chassis, and is radiated efficiently. The temperature sensor 4441 is exemplified by the one having a platinum film thinly deposited on the sheet, a thin posistor and a carbon resistance film.

A concave portion is formed on the sealing lid 40 or the array board 30 so that the temperature sensor 4441 can be inserted into the concave portion so as to follow the temperature change well. The concave portion may be the space between the sealing board 40 and the array board 30 in FIG. 3. In particular, the organic EL is not a transmissive type, and so a light shielding object may be placed on the backside. Therefore, the temperature sensor 4441 may also be placed in the center of the display panel. It goes without saying that the temperature sensor 4441 may be placed at multiple locations on the backside of the display area of the display panel.

The temperature sensor 4441 has a certain constant current I supplied thereto. If the temperature sensor 4441 is heated, a resistance value increases and so the resistance value between terminals a and b increases. This change in the resistance value is detected by a detector 4443, and a detection result is transmitted to a controller circuit (IC) 760. The controller circuit (IC) 760 performs the duty ratio control and reference current control based on the result of the detector 4443 so as to keep the array board 30 and so on from being heated above a certain level. It is also possible to insert the temperature sensors serially into an anode line or a cathode line and reduce a voltage Vdd supplied from the anode line according to change in the resistance of the temperature sensor 4441.

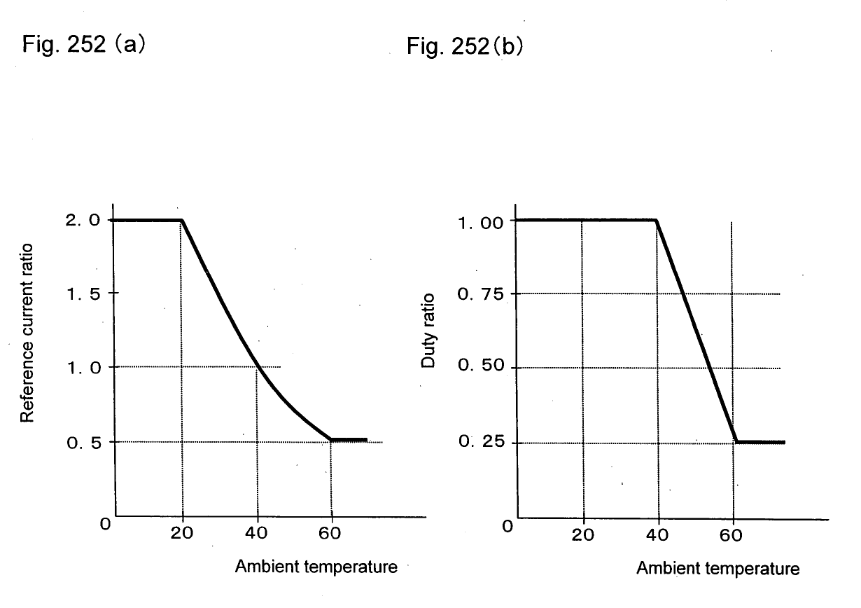

FIG. 252(a) is an embodiment in which the reference current ratio is changed according to the ambient temperature. As the ambient temperature rises, the reference current is suppressed (reduced) to reduce the consumption current of the panel and suppress the self heating. FIG. 252(b) is an embodiment in which the duty ratio is changed according to the ambient temperature. As the ambient temperature rises, the duty ratio is reduced to reduce the consumption current of the panel and suppress the self heating. It goes without saying that the reference current ratio control in FIG. 252(a) may be combined with the means of reducing the consumption current such as the duty ratio control in FIG. 252(b).

The embodiment exemplified the temperature sensor 4441 as the one changing its resistance according to the temperature. However, the present invention is not limited thereto. It may also be the one for providing an instruction to the controller circuit (IC) 760 by detecting an infrared. It may also be the one for generating an electromagnetic wave due to the temperature change. To be more specific, it may be any of those as long as it can detect the temperature change of the panel.

It is possible to control the temperature change by integrating the temperature change so that, when that integration value exceeds a predetermined value, current suppression means such as the duty ratio control is operated. On performing the integration, it is desirable to consider reduction in the panel temperature due to radiation from the panel. Therefore, it should not be simply controlled by the integration value but it should be controlled by deducting an amount of radiation. The amount of radiation can be easily derived by an experiment.

The present invention detects the temperature or something similar (emission of the infrared for instance) and performs the duty ratio control and so on so as to prevent the panel from being overheated and deteriorated. However, the present invention is not limited to this. FIG. 468 shows another example of the present invention.

In FIG. 468, the consumption current of the panel is calculated from the current passing through the anode or the cathode or the current passing through the EL element 15 of the panel, the temperature of the panel is predicted or estimated and an overheated state of the panel is grasped so as to perform the means or method of suppressing or reducing the consumption current of the panel, such as the duty ratio control and reference current ratio control.

The current driving method has the current and luminance in a linear (proportional) relation. For that reason, it is possible, as described in FIG. 88, to acquire the power consumption of the panel by calculating the sum total of the video data. If the sum total of the video data of one screen is integrated by a time axis, it makes electric energy or an index indicating the electric energy. It is also possible, by means of the experiment, to derive the relation between electric power and heat generation and the relation among the heat generation, radiation and cooling.

It is possible, as described above, to estimate or predict the temperature of the panel by acquiring the sum total of the video data, integrating the sum total and deducting the amount of radiation from the integration value. In the case where the temperature of the panel rises or may rise exceeding the prescription as a result of the prediction, the duty ratio control and reference current ratio control are performed to suppress the power consumption of the panel. When it is predicted that the temperature of the panel is reduced to below a prescribed temperature due to suppression, the normal duty ratio control and reference current ratio control are performed.

FIG. 468 shows the embodiment of the driving method of the present invention described above. The video data (red is RDATA (R), green is GDATA (G), and blue is BDATA (B)) is weighted. The data is weighted because the EL element 15 has different luminous efficiencies according to RGB and so the power consumption cannot be predicted or estimated by simple addition of the video data.

To simplify the description, the description will be given hereafter on the assumption that the video data of R, G and B is weighted and added. The addition is R·A1+GA2+B·A3 for instance. This calculation is performed to each of the pixel data, and the sum total is acquired for each frame (field) as an example. It is desirable to have A1+A2+A3=K, where K is a multiplier of 2 which is 4 or more (4, 8, 16, 32 . . . ). K=4 can be represented by 2 bits. K=8 can be represented by 3 bits. K=16 can be represented by 4 bits. As the R, G and B are the video data, it is normally 6 bits or 8 bits. If set up as above, the value calculated by R·A2+G·A2+BA3 can be represented by a certain bit length so that usability of the memory is good. As a matter of course, the usability is good as to the memory for storing the sum total calculated by R·A1+G·A2+B·A3 for each pixel. The usability is also good and the calculation can be easily performed as to the bit length of a register or an accumulator in the middle of the calculation.

If A1+A2+A3=16, it can be represented that weighting of R is 5, weighting of G is 5, and weighting of B is 6 for instance. Also, it can be represented that weighting of R is 6, weighting of G is 2, and weighting of B is 8 for instance. To be more specific, a wide variety of representations are performed according to the luminous efficiencies of the EL elements of the RGB. It is desirable to set the values of A1, A2 and A3 so as to indicate the ratio of the current consumed on taking the white balance with the RGB.

The values of A1, A2 and A3 may be changed according to the kind of image. For instance, the value of A3 is increased in the case where blue color such as the sea is displayed much or continued. The value of A1 is increased in the case where red color such as the sunset is displayed much or continued.

The embodiment described that the R, G and B are the video data. However, it is not limited thereto. It may be equivalent to the video data having undergone (inverse) gamma conversion. It may also be the video data having undergone arithmetic processing.

The above was already described in the embodiment in FIG. 88 and so on, and so a description thereof will be omitted. To facilitate the description, it is described that the input data is the RGB data (red is RDATA, green is GDATA, and blue is BDATA). However, it is not limited thereto. It may also be YUV (luminance data and color data). In the case of the YUV, weights are assigned to Y (luminance) data or Y data and UV (color) data directly or by converting it to the luminance data in consideration of the luminous efficiency to the color. It is also possible to perform the arithmetic processing by using only the Y data. It is also possible to perform a predetermined weighting process to the Y data.

It goes without saying that the duty ratio of a current operating state is considered in the case of performing this operation. It is because, when the duty ratio is small, the current flowing into the panel is small even if the weighted data is large so that the panel is not put in the overheated state.

RDATA (R) is multiplied by a constant A1. GDATA (G) is multiplied by a constant A2. BDATA (B) is multiplied by a constant A3. As for the multiplied data, current data (or similar data) equivalent to one screen is sought in a sum total circuit (SUM) 884. The sum total circuit 884 sends it to a comparator 4681. The comparator 4681 compares it to preset comparison data (a value or data set to indicate the overheated state at a predetermined current data or more). In the case where the current data is equal to or larger than the comparison data, it controls a counter circuit 4682 to increase a counter value thereof by one. In the case where the current data is smaller than the comparison data, it decreases the counter value of the counter circuit 4682 by one.

The operation is continued and in the case where the counter value of the counter circuit 4682 reaches or exceeds a predetermined value, the controller circuit (IC) 760 controls a gate driver 12b to reduce the duty ratio and suppress the current passing through the panel. Therefore, the panel will not be overheated and deteriorated.

It goes without saying that the constants A1, A2 and A3 should desirably be rewritable with a command by the controller circuit (IC) 760. It goes without saying that it may be manually rewritable by the user, as a matter of course. It also goes without saying that the comparison data of the comparator 4681 should desirably be rewritable.

As the EL element 15 is temperature-dependent, the constants should desirably be rewritten according to the temperature of the panel. The luminous efficiency also changes according to the lighting rate (also according to the size of the current passing through the EL element 15). Therefore, it is also desirable to rewrite the constants according to the lighting rate. As the description was given in FIG. 88 and so on, and so a description thereof will be omitted since the other descriptions are similar or the same.

If a bright screen and dark screen alternate quickly and the duty ratio, the reference current, etc. are varied accordingly, flicker occurs. Thus, when the duty ratio, is changed from one value to another, preferably hysteresis (time delay) is provided as shown in FIG. 98. For example, if a hysteresis period is 1 sec., even if the screen changes its brightness a plurality of times within the period of 1 sec., the previous duty ratio is maintained. That is, the duty ratio does not change. It goes without saying that the above is also applicable to the reference current control. As shown in FIG. 98, the change may be different among the R, G and B.

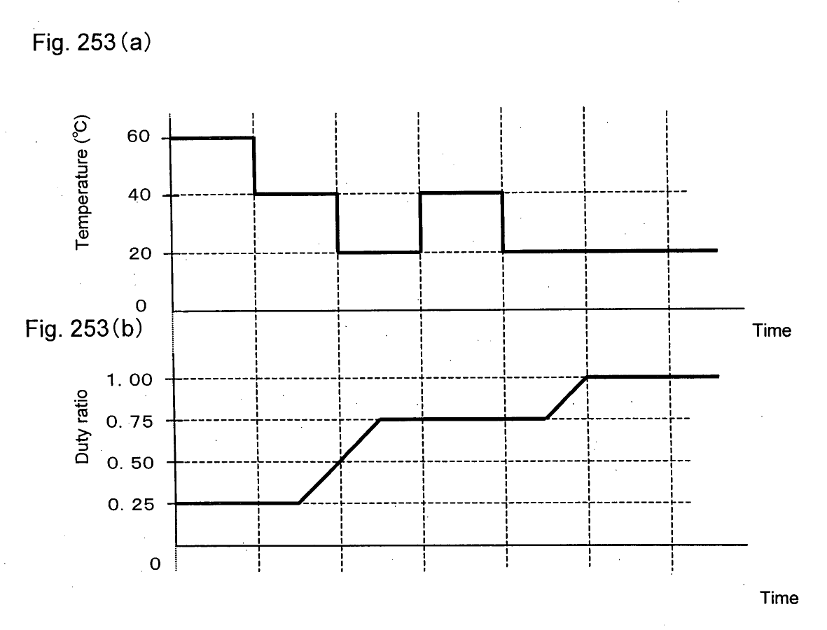

The hysteresis time (time delay) is referred to as a Wait time. Also, the duty ratio before the change is referred to as a pre-change duty ratio and the duty ratio after the change is referred to as a post-change duty ratio. It is called a hysteresis (time delay). The hysteresis also has meaning of slowly making a change. For instance, an example is shown, where it is changed slowly by taking the time of two seconds when changing the duty ratio from 1/1 to ½(control is exerted mostly by this method). An example is shown in FIG. 253. As shown in FIG. 253(b), the controller circuit (IC) 760 is controlled to change the duty ratio slowly against the change in the temperature of the panel in FIG. 253(a).

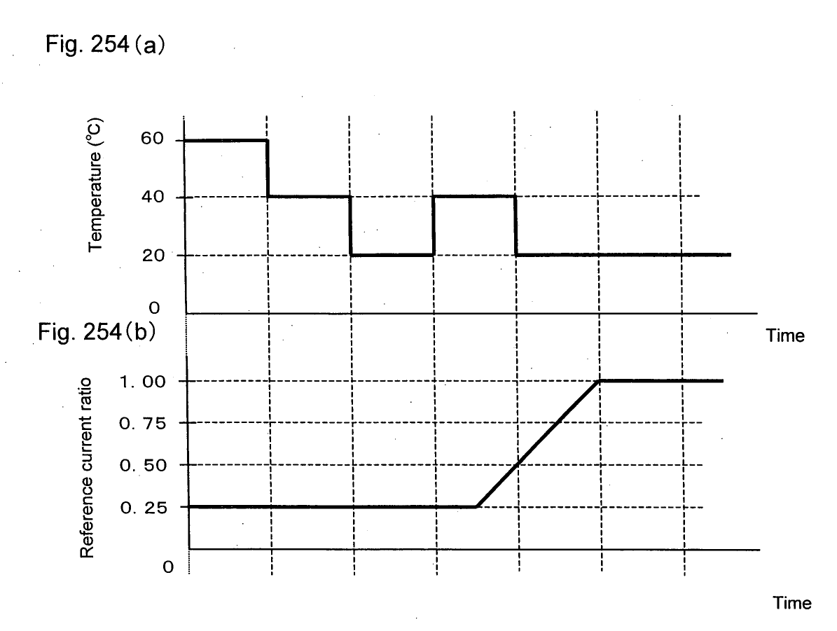

The same is also applied to the reference current ratio control. FIGS. 254 show this embodiment. As shown in FIG. 254(b), the controller circuit (IC) 760 is controlled to change the reference current ratio slowly against the change in the temperature of the panel in FIG. 254(a).

If a small pre-change duty ratio changes its value, the change tends to cause flicker. A small pre-change duty ratio means a small sum of screen data or a large black display part on the screen.

In particular, the change is made slowly at a gray level or around a medium value of the lighting rate. Maybe the screen presents intermediate gradations, resulting in high luminosity. Also, in an area with a small duty ratio, difference between pre-change and post-change duty ratios tends to be large. Of course, if there is a large difference of duty ratios, an OEV should be used for control. However, there is a limit to OEV control. In view of the above circumstances, the wait time should be increased when a pre-change duty ratio is small.

If a small pre-change duty ratio changes its value, the change is less prone to cause flicker. A large pre-change duty ratio means a large sum of screen data or a large white display part on the screen. Maybe the entire screen presents a white display, resulting in low luminosity. In view of the above circumstances, the wait time may be short when a pre-change duty ratio is large.

The above relationship is shown in FIG. 98. The horizontal axis represents the pre-change duty ratio and the vertical axis represents the Wait time (seconds). When the duty ratio is 1/16 or less, the Wait time is as long as 3 seconds. Taking B(blue) as an example, when the duty ratio is between 1/16 and 8/16(=½), the Wait time is varied between 3 seconds and 2 seconds depending on the duty ratio. When the duty ratio is between 8/16 and 16/16(= 1/1), the Wait time is varied between 2 seconds and around 0 seconds depending on the duty ratio.

In this way, the duty cycle control according to the present invention varies the Wait time with the duty ratio. When the duty ratio is small, the Wait time is increased and when the duty ratio is large, the Wait time is decreased. That is, in a drive method which varies at least the duty ratio, a first pre-change duty ratio is smaller than a second pre-change duty ratio and the Wait time for the first pre-change duty ratio is set longer than the Wait time for the second pre-change duty ratio.

The embodiment controls or prescribes the wait time in reference to the pre-change duty ratio. However, the difference between the pre-change duty ratio and the post-change duty ratio is little. Therefore, the pre-change duty ratio may be replaced by the post-change duty ratio in the aforementioned embodiment.

The embodiment was described in reference to the pre-change duty ratio and the post-change duty ratio. It goes without saying that, when the difference between the pre-change duty ratio and the post-change duty ratio is large, a long wait time should be taken. It also goes without saying that, when the difference between the duty ratios is large, it is good to change to the post-change duty ratio by way of the duty ratio in an intermediate state.

The duty cycle control method according to the present invention provides a long Wait time when there is a large difference between pre-change and post-change duty ratios. That is, it varies the Wait time depending on the difference between pre-change and post-change duty ratios. Also, it allows for a long Wait time when there is a large duty ratio difference. As previously described, the wait time or hysteresis means to change it slowly. It goes without saying that it also means to delay the start of the change in a broad sense, as a matter of course.

Also, the duty ratio method according to the present invention provides an intermediate duty ratio before a post-change duty ratio when there is a large duty ratio difference.

In the example shown above, different Wait time is used for red (R), green (G), and blue (B). Needless to say, however, the present invention allows the Wait time to be varied among R, G, and B. This is because luminosity varies among R, G, and B. By specifying the Wait time according to luminosity, it is possible to achieve better image display.

The above example concerns duty cycle control. Preferably, Wait time is specified in reference current control as well.

As described above, the driving method of the present invention does not change the duty ratio and reference current drastically. It is because a changing state is recognized as a flicker if drastically changed. Under normal circumstances, they are changed with a delay of 0.2 to 10 seconds. It goes without saying that the above is also applicable to change control of anode voltage, change control of pre-charge voltage and change control by the ambient temperature (changing the duty ratio and reference current according to the panel temperature) described later.

A small reference current makes the display screen 144 dark while a large reference current makes the display screen 144 bright. In other words, a low magnification of reference current means an intermediate-gradation display mode. When the magnification of reference current is high, the screen is in high-brightness mode. Thus, when the magnification of reference current is low, the Wait time should be increased because of high visibility of changes. On the other hand, when the magnification of reference current is high, the Wait time may be decreased because of low visibility of changes.

The duty cycle control described above does not need to complete in a single frame or single field. Duty cycle control may be performed at intervals of a few fields (few frames). In that case, an average duty ratio over a few fields (few frames) is used. Incidentally, when performing duty cycle control at intervals of a few fields (few frames), preferably each interval should contain not more than 6 fields (6 frames). A longer period may cause flicker. Also, the number of fields (frames) does not need to be an integer, and may be, for example, 2.5 frames (2.5 fields). That is, the present invention is not limited to a specific number of fields (frames) per period.

It goes without saying that the above is applicable not only to the EL display panel or the EL display apparatus of the pixel configuration in FIG. 1 but also to the EL display panel or the EL display apparatus of other pixel configurations in FIGS. 2, 7, 8, 9, 11, 12, 13, 28, 31 and 36.

Duty ratio patterns are varied between moving pictures and still pictures. If a duty ratio pattern is changed sharply, changes in the image may be perceived. Also, flicker may occur. This problem is caused by difference between duty ratios of moving pictures and still pictures. Moving pictures employ a duty ratio pattern which involves inserting an undivided non-display area 192. Still pictures employ a duty ratio pattern which involves inserting a divided non-display area 192 in a scattered manner. The surface ratio between non-display area 192 and screen area 144 provides the duty ratio. However, even if the duty ratio is the same, human visibility varies with the distribution of non-display areas 192. It is believed that human responsiveness to moving pictures plays a role here.

An intermediate moving picture has a distribution pattern midway between the distribution pattern of a moving picture and distribution pattern of a still picture in a non-display area 192. A plurality of modes may be prepared for intermediate moving pictures and one of a plurality of moving pictures may be selected according to a movie mode or still picture mode before change. The plurality of intermediate movie modes may include, for example, a distribution pattern close to that of movie display—such as a distribution pattern with a non-display area 192 divided into three parts—or conversely, a distribution pattern in which a divided non-display area is scattered widely as is the case with a still picture.

There are various still pictures: some are bright, others are dark. The same applies to moving pictures. Thus, the intermediate movie mode to change over to may be determined according to the mode before the change. In some cases, a change from a moving picture to a still picture may occur directly without going through an intermediate moving picture. For example, on a dark display screen 144, a change from a movie display to a still picture display can take place directly without a feeling of strangeness. On the other hand, display modes may be switched via a plurality of intermediate movie displays. For example, it is possible to change from a duty ratio for a movie display, through a duty ratio for an intermediate movie display 1 and a duty ratio for an intermediate movie display 2, and to a duty ratio for a still picture display.

A change from a movie display to a still picture display occurs by way of an intermediate movie mode. Also, a change from a still picture display to a movie display occurs by way of an intermediate movie mode. Preferably a Wait time is provided in a change between different display modes. When shifting from the still image to the moving image or the intermediate moving image, the change in the non-display area 192 should be slow.

FRC (Frame Rate Control) and the moving image display are related. The number of frames should be that used by the FRC (for instance, 4 frames are used in 4 FRC to perform gradation display equivalent to 2 bits (4 times the number of gradations), and 16 frames are used in 16 FRC to perform gradation display equivalent to 4 bits (16 times the number of gradations)). If n (the number of frames) of n FRC (n is an integer of 2 or more) increases, however, moving image performance lowers in the case of the moving image while there is no problem as to the still image. Therefore, n of n FRC should desirably be small in the moving image display. The moving image display does not require more than a certain number of gradations. In most cases, 256 or less gradations are sufficient. The still image requires a large number of gradations.

To solve this problem, the present invention changes the number n of n FRC (called the FRC number) based on the ratio of the moving image pixels as shown in FIG. 443. The ratio of the moving image pixels is the ratio of the pixels determined as the pixels of the moving image by frame operation.

For instance, a difference between the pixel data at the same position is acquired between a first frame and a following second frame so as to determine it as the moving image pixel in the case where the value of the difference is a certain value or more. If the number of pixels of one panel is 100,000, the ratio of the moving image pixels is 25 percent when the ratio of the pixels determined as the moving image pixels by the difference operation is 25,000.

In the embodiment in FIG. 443, it is determined as a complete still image or close to it with 16 FRC (n=16) when the ratio of the moving image pixels is 0 to 25 percent. It is determined as an intermediate image close to the moving image with 12 FRC (n=12) when the ratio of the moving image pixels is 25 to 50 percent. Moreover, it is determined as an intermediate image close to the still image with 8 FRC (n=8) when the ratio of the moving image pixels is 50 to 75 percent. It is determined as a complete moving image or close to it with 1 FRC (n=1, which means no FRC control.) when the ratio of the moving image pixels is 75 percent or more.

It is possible, as described above, to implement an optimal image display by changing the FRC based on the contents of the display image. The change of the FRC is performed by the controller circuit (IC) 760's.

The change of the FRC should be performed when a scene of the image suddenly changes. The state in which the scene of the image suddenly changes is when the screen changes to a commercial, when the channel is switched or when the scene of a drama changes, for instance. The sudden change of the scene is also described in the peak current suppression and duty ratio control of the present invention.

Therefore, in the case where the ratio of the moving image changes, the screen is put in a flicker-like display state if the FRC number of n FRC is changed in real time. Therefore, it is desirable to change the FRC number on the sudden change of the scene.

The pre-charge driving was described in FIGS. 16 and 75. It is desirable to apply the pre-charge voltage in conjunction with the lighting rate or the duty ratio. It is desirable to apply no pre-charge voltage to a location where it is not necessary. This is because it may cause reduction in the luminance of the white display. Therefore, it is desirable to limit the application of the pre-charge voltage.

The pre-charge driving is performed in order to resolve a phenomenon of having crosstalk below a white display portion especially in the current driving method. Therefore, the crosstalk is highly visible when the screen has a lot of black display portions and has the white display portions in part. To indicate it by the lighting rate, the pre-charge is necessary in an area of a low lighting rate. This is because, even when the crosstalk is generated, it is not visually recognized if the entire display screen 144 is in the white display. Therefore, it is not necessary to perform the pre-charge driving.

The present invention reduces the duty ratio when the lighting rate is high (the entire display screen 144 has a lot of white display portions). To be more specific, n of the duty ratio 1/n is increased. The duty ratio is increased when the lighting rate is low (the entire display screen 144 has a lot of black display portions) To be more specific, it gets closer to the duty ratio 1/1. Therefore, the duty ratio and the lighting rate are correlated. It is natural because the lighting rate is acquired from the video data and the duty ratio control is performed based on the lighting rate. The lighting rate is also related to the pre-charge control.

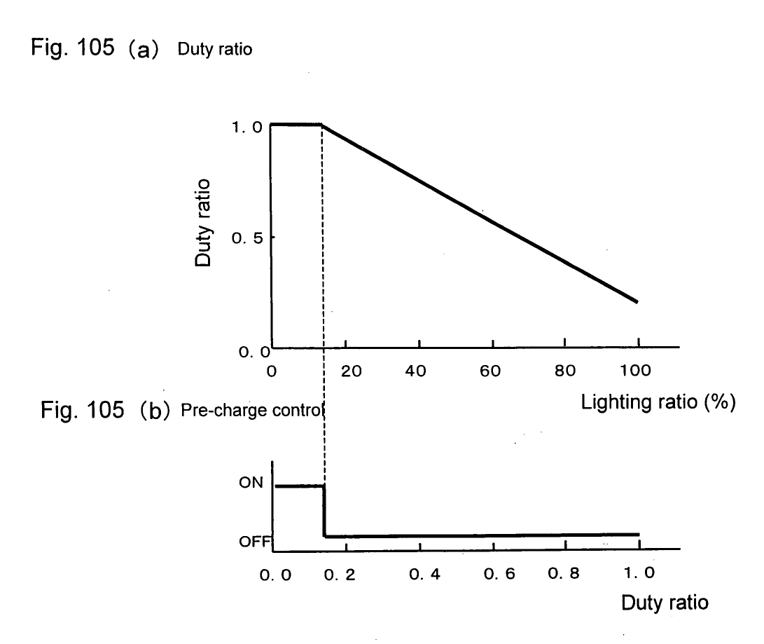

The duty ratio and the lighting rate (%) are related as shown in FIG. 105(a). FIG. 105(b) shows on and off states of the pre-charge. In FIG. 105(b), it is set up to perform the pre-charge driving at the duty ratio of 20 percent or less. When performing the pre-charge driving, however, the pre-charge driving of the present invention has an all pre-charge mode, an adaptive pre-charge mode, a 0-gradation pre-charge mode and a selective gradation pre-charge mode. Therefore, in FIG. 105(b), it is important to set to perform the pre-charge driving. And the driving state is different depending on which pre-charge is performed. What is important is to change whether or not to perform the pre-charge driving according to the duty ratio or the lighting rate.

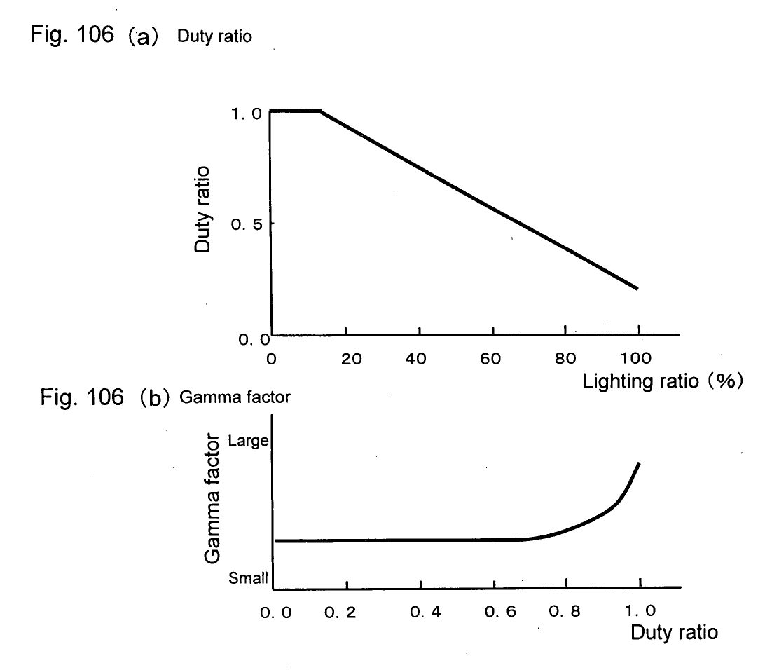

The duty ratio or the lighting rate (%) and gamma control are also related. FIG. 106 is a schematic diagram thereof. Many of the images of which lighting rate is high have high luminance overall. For that reason, the image becomes whitish. Therefore, it is desirable to render a coefficient of a gamma constant (the coefficient is normally 2.2) larger so as to increase the area of the black gradation region. The image gains a lively feeling if the area of the black gradation region is increased.

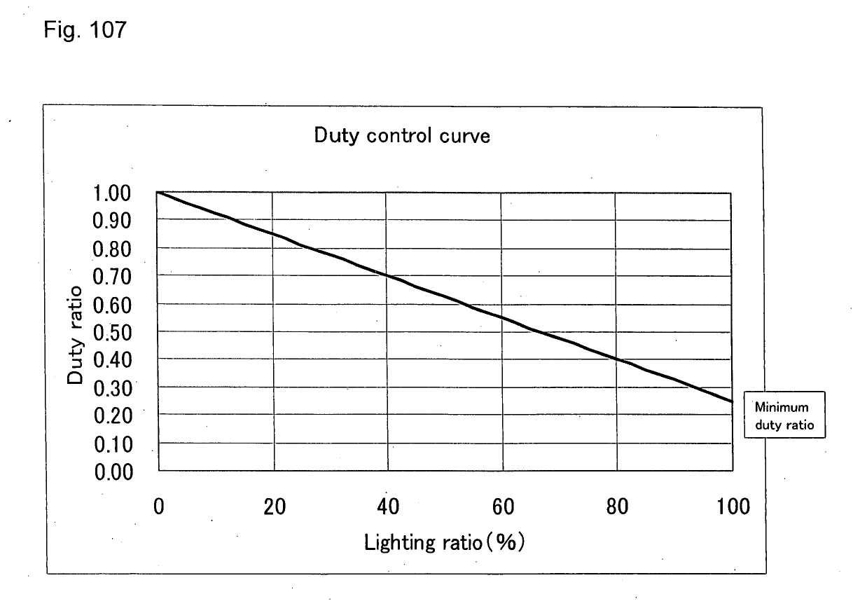

The duty ratio against the lighting rate is shown in FIG. 107. According to the control in FIG. 107, the duty ratio is approximately ¼ if the lighting rate of the display image is nearly 100 percent. The gradation is proportional to the luminance. The image of a high lighting rate needs to have a change made to the gamma curve so as not to have the gradation display of the image collapsed and become an image of no resolution. To be more specific, it is necessary to increase the coefficient as a multiplier of the gamma curve so as to render the gamma curve precipitous.

Thus, the present invention changes the coefficient of the gamma curve according to the lighting rate or the duty ratio. FIG. 106 is a schematic diagram thereof.

The present invention reduces the duty ratio when the lighting rate is high (the entire display screen 144 has a lot of white display portions). To be more specific, n of the duty ratio 1/n is increased. The duty ratio is increased when the lighting rate is low (the entire display screen 144 has a lot of black display portions) To be more specific, it gets closer to the duty ratio 1/1. Therefore, the duty ratio and the lighting rate are correlated. It is natural because the lighting rate is acquired from the video data and the duty ratio control is performed based on the lighting rate.

The relation between the duty ratio and the lighting rate (%) is as shown in FIG. 106(a). The graph of FIG. 106(b) has its vertical axis showing the coefficient of the gamma curve. In FIG. 106(b), there is a setup that the coefficient of the gamma curve increases at the duty ratio of 70 percent or more. To be more specific, gradation representation becomes larger in the high gradation region so as to render the gamma curve precipitous. Thus, a white crushed image is improved.

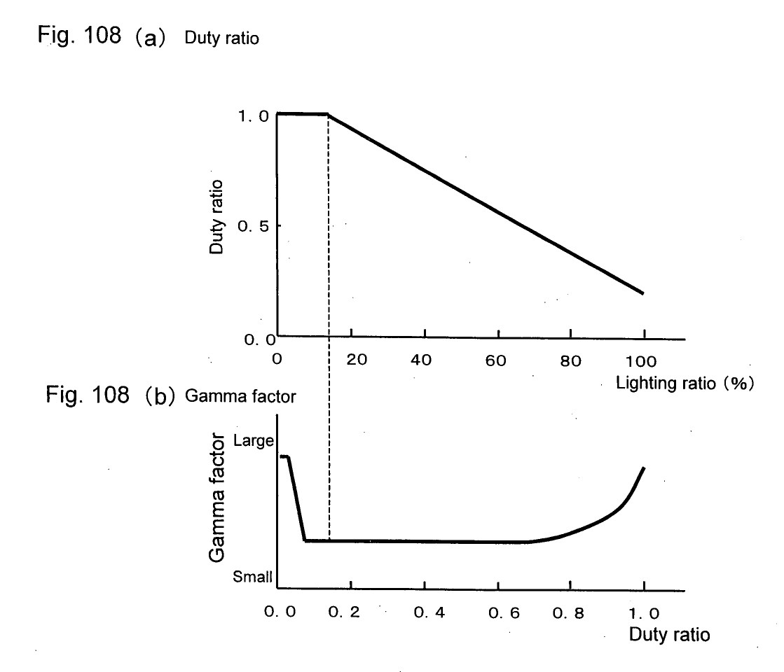

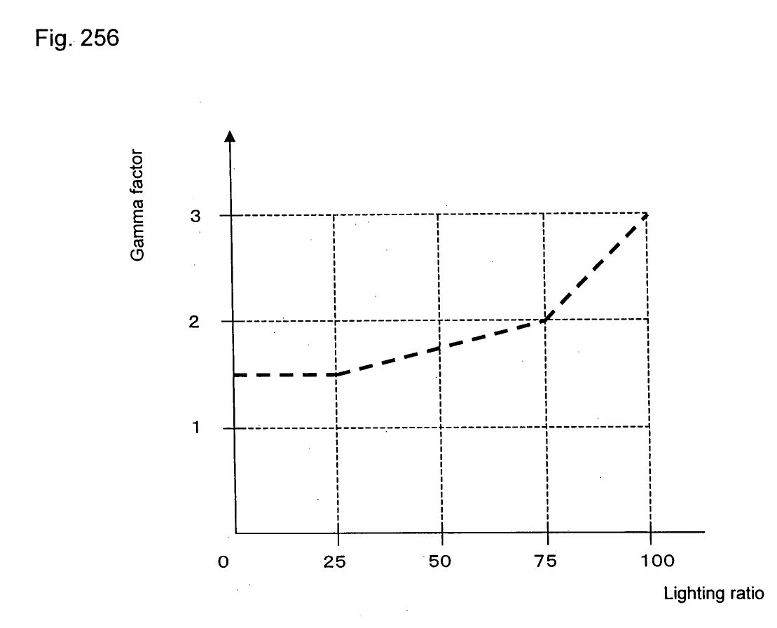

As shown in FIGS. 108(a) and (b), there are the cases where the image display can be improved by increasing the gamma coefficient in a small area of which duty ratio is a certain value or more. It is possible, as described above, to implement a lively image display by changing the gamma curve correspondingly to the lighting rate (data sum of the image). FIG. 256 shows an embodiment in which the gamma coefficient is changed against the lighting rate.

The duty ratio control is closely related to the power supply capacity. The power supply size becomes larger as the maximum power supply capacity increases. In particular, the large power supply size is a serious problem in the case where the display apparatus is mobile. The EL has the current and luminance in a proportional relation. No current passes in the black display. The maximum current passes in the white raster display. Therefore, the current changes significantly according to the image. If the current changes significantly, the power supply size becomes larger and the power consumption increases.

The present invention increases n of the duty ratio control 1/n and reduces the consumption current (power consumption) when the lighting rate is high. Inversely, the present invention sets the duty ratio at 1/1=1 or close to 1/1 when the lighting rate is low so as to display the maximum luminance. This control method will be described below.

First, FIG. 107 shows the relation between the lighting rate and the duty ratio. The lighting rate is converted from the current passing through the panel as previously described. It is because the luminous efficiency of B is poor on the EL display panel and so the power consumption increases at once if the sea or something similar is displayed. Therefore, the maximum value is that of the power supply capacity. And the data sum is not a simple added value of the video data but the video data converted to the consumption current. Therefore, the lighting rate is also acquired from a working current of each image against the maximum current.

FIG. 107 shows an example in which the duty ratio is 1/1 at the lighting rate of 0 percent and the lowest duty ratio is ¼ at the lighting rate of 100 percent. FIG. 109 shows a result of multiplying the electric power by the lighting rate. If the duty ratio is constantly 1/1 at the lighting rates of 0 to 100 percent in FIG. 107, it becomes the curve denoted by reference character a in FIG. 109. The vertical axis of FIG. 109 is the ratio of the working current to the power supply capacity (power ratio). To be more specific, the lighting rate is proportional to the power consumption as regards the curve a. Therefore, the power consumption is 0 (power ratio: 0) at the lighting rate of 0 percent, and it is 100 (power ratio: 100%) at the lighting rate of 100 percent.

A curve b in FIG. 109 is an embodiment in which power restriction is performed by the duty ratio curve of FIG. 107. As the duty ratio is ¼ at the lighting rate of 100 percent, the power ratio is ¼, that is, 25 percent of the curve a. The curve b is operating in a range smaller than ⅓ of the power. Therefore, if the duty ratio control is performed as in FIG. 107, the sufficient power supply capacity can be ⅓ compared to the conventional case (curve a). To be more specific, according to the present invention, the power supply size can be smaller compared to the conventional case.

If the state of the high lighting rate continues in the conventional case (curve a), the current passing through the panel becomes so large that the panel deteriorates due to the heat generation. According to the present invention wherein the duty ratio control is performed, however, an average current passes through the panel irrespective of the lighting rate as is understandable from the curve b. Therefore, it has little heat generation and no deterioration of the panel.

A curve c is an embodiment in which the lowest duty ratio is ½ as regards the duty ratio curve of FIG. 107. A curve d is an embodiment in which the lowest duty ratio is ⅓. Likewise, a curve e is an embodiment in which the lowest duty ratio is ⅛.

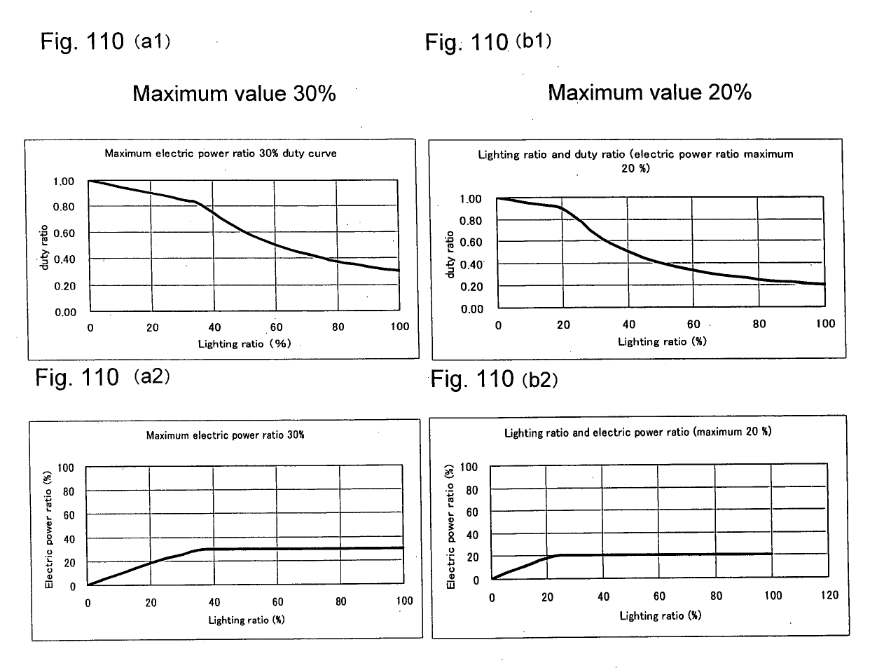

FIG. 107 shows the duty ratio curve as a straight line. However, the duty ratio curves can be generated as various kinds of straight lines and curves. For instance, FIG. 110(a1) shows a duty ratio control curve for setting the power ratio at 30 percent or less (refer to FIG. 110(a2)). FIG. 110(b1) shows a duty ratio control curve for setting the power ratio at 20 percent or less (refer to FIG. 110(b2)). As described above, it is desirable to configure the duty ratio curve or the reference current ratio curve to be variable by programming of the microcomputer or external control.

As for the duty ratio control curve, the user can freely switch between (a) and (b) of FIG. 110 with a button according to the external environment. The duty ratio curve of FIG. 110(a1) should be selected in a bright external environment, and the duty ratio curve of FIG. 110(b1) should be selected in a dark external environment. It is desirable to configure the duty ratio control curve to be freely variable.

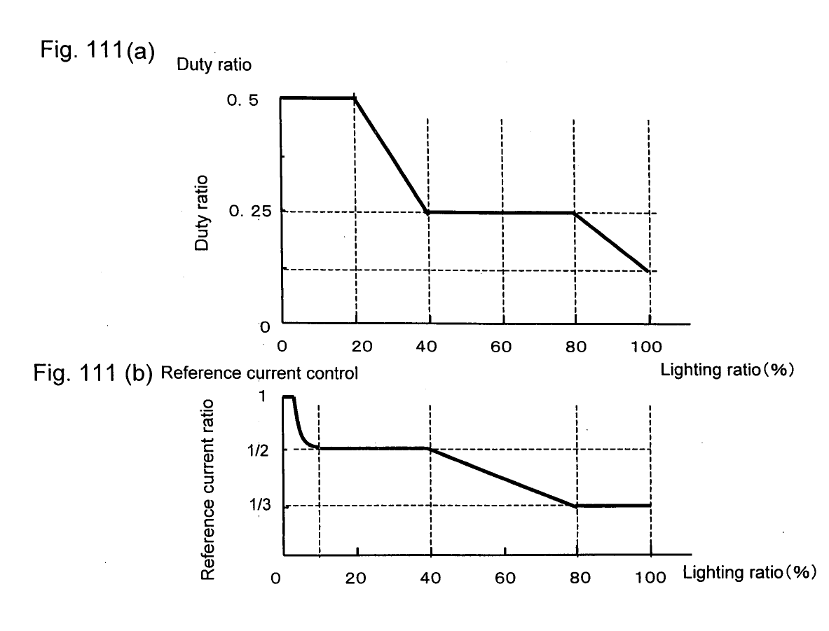

The embodiment was described in reference to the case where the reference current is 1 and on condition that the maximum duty ratio is 1/1. However, the present invention is not limited to this. For instance, it is also possible, as shown in FIG. 111, to change the reference current to 1 or ⅓ centering on ½. The maximum may be set at 0.5. It is also possible to change the duty ratio to 0.5 or less centering on 0.25. The maximum may be set at 0.5.

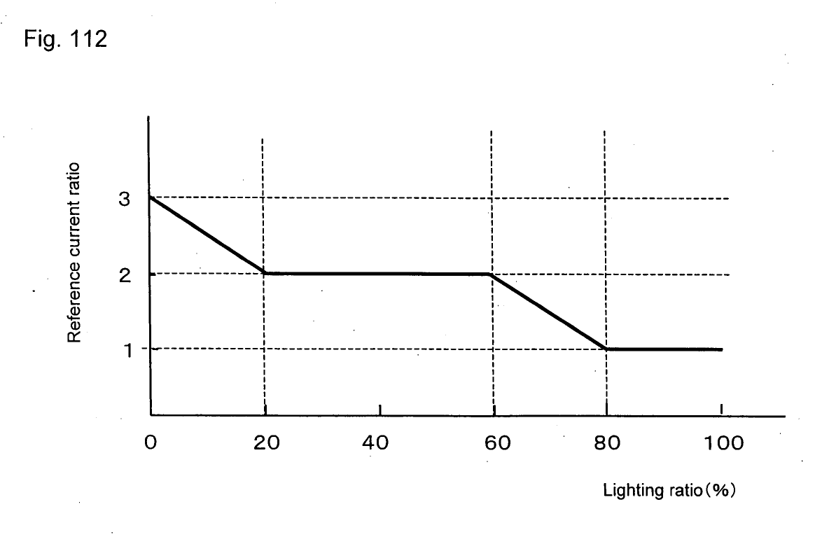

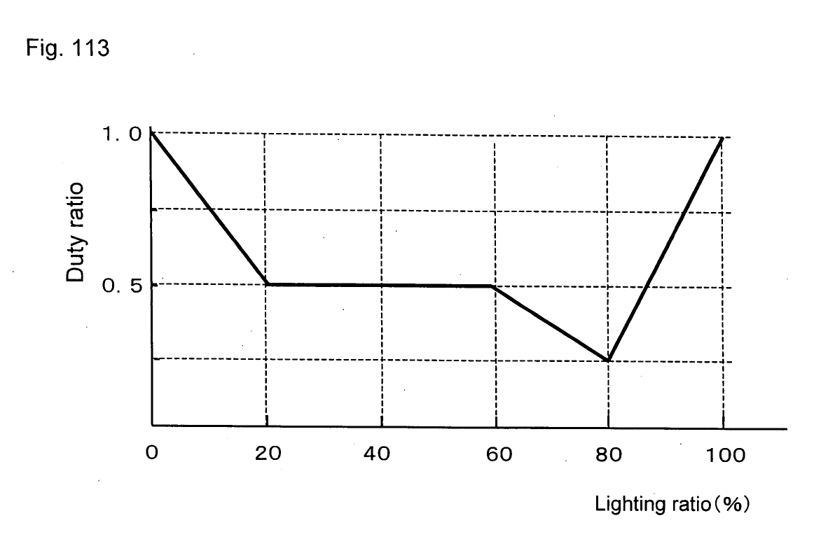

As shown in FIG. 112, it is possible to change the reference current to multiple values with its minimum value at 1 and maximum value at 3 and use it. It goes without saying that the duty ratio may be controlled to be the lowest at the lighting rate of 80 percent and increased at 100 percent or 60 percent as shown in FIG. 113.

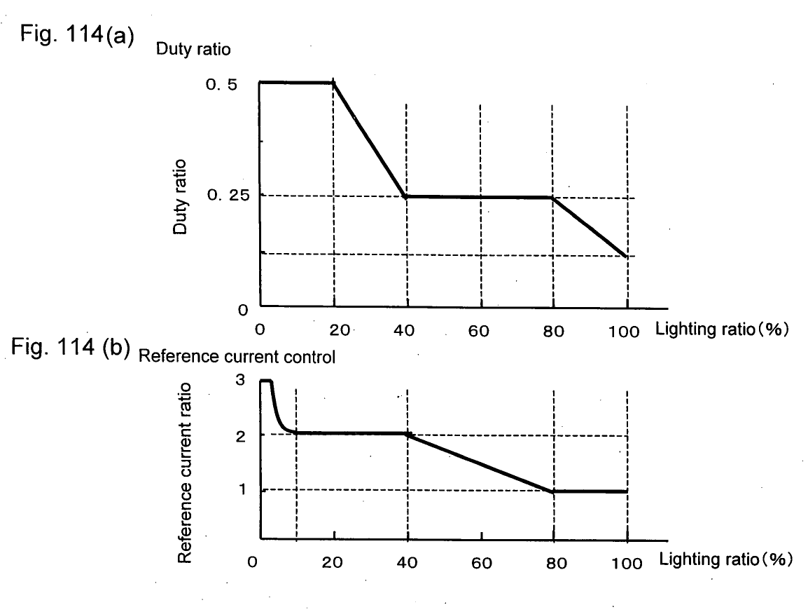

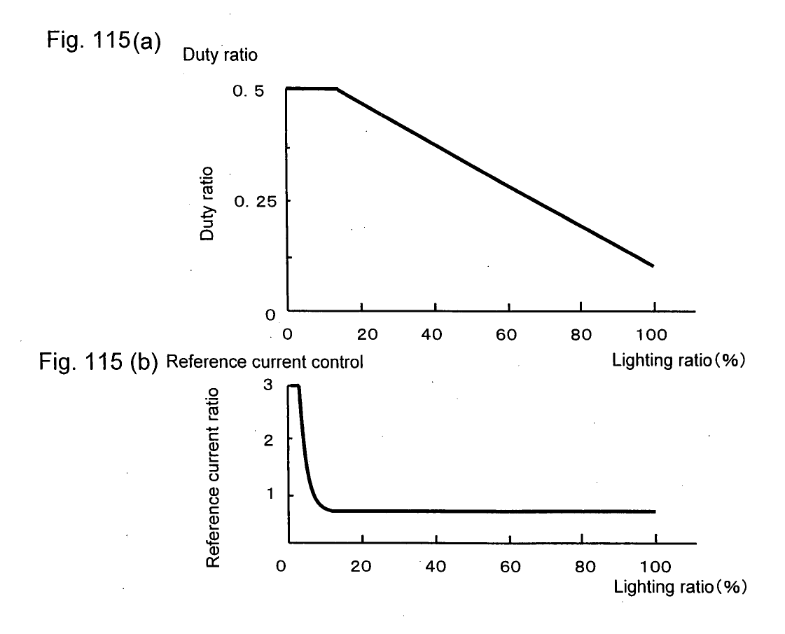

As shown in FIGS. 114(a) and(b), the reference current may be changed to 3 or 1 centering on 2. The maximum may be set at 3. It goes without saying that the duty ratio may be changed to 0.25 with the maximum value at 0.5. This also applies to FIGS. 115(a) and (b).

As shown in FIGS. 116, it is possible to reduce the duty ratio in a low lighting rate region (lighting rate of 20 percent or less in FIGS. 116) (FIG. 116 (a)) and increase the reference current ratio in conjunction with the reduction in the duty ratio (FIG. 116(b)). As shown in FIG. 116(c), the luminance no longer changes if the duty ratio control and reference current ratio control are simultaneously performed as described above. At the low lighting rate, shortage of writing of a program current in the low gradation region is conspicuous. It is possible, however, to increase the reference current in the low lighting rate region as in FIGS. 116 and thereby increase the program current in proportion to the reference current so that there is no longer the shortage of writing of the program current. And the luminance is also constant so as to implement a good image display.

In FIGS. 116, the duty ratio is lowered in a high lighting rate region (40 percent or more in FIGS. 116) but the reference current ratio remains constant at 1. Therefore, it is possible to control (basically reduce) the power consumption of the panel because the luminance lowers along with the reduction in the duty ratio. As for the driving method of setting the maximum duty ratio at 1/1, it is desirable to insert the non-display areas 192 collectively.

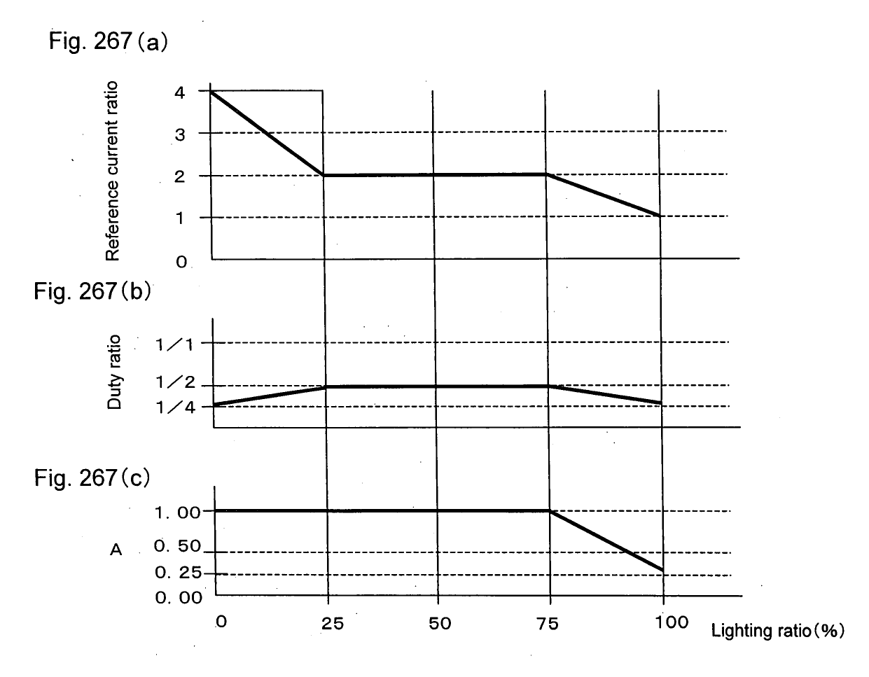

As for the relation among the ff reference current ratio, the duty ratio and the lighting rate, it is desirable to keep a constant relation as will be described below. It is because increase in occurrences of the flicker or deterioration due to the self heating of the panel is accelerated otherwise. FIG. 267 is an example thereof. In FIG. 267(c), a vertical axis A indicates duty ratio×reference current ratio. Basically, it is desirable to control A to be close to 1 in a low lighting rate region. It is desirable to control A to be smaller than 1 in the high lighting rate region As a result of examination, it is desirable to set duty ratio×reference current ratio (A) at 0.7 to 1.4 in the region of the lighting rate of 30 percent or less. More preferably, it is set at 0.8 to 1.2. It is desirable to control or set duty ratio×reference current ratio (A) at 0.1 to 0.8 in the region of the lighting rate of 80 percent or less. It is further desirable to control or set it at 0.2 to 0.6.

If duty ratio×reference current ratio at the lighting rate of 50 percent is A, it is desirable to set or control duty ratio×reference current ratio×A at 0.7 to 1.4 in the region of the lighting rate of 30 percent or less. It is further desirable to set or control it at 0.8 to 1.2. It is desirable to set or control duty ratio×reference current ratio A at 0.1 to 0.8 in the region of the lighting rate of 80 percent or less. It is further desirable to set or control it at 0.2 to 0.6.

In the embodiment of FIG. 267, the duty ratio is lowered and the reference current ratio is increased in inverse proportion in the low lighting rate region (lighting rate of 25 percent or less in FIG. 267). Therefore, the relation in which A as duty ratio×reference current ratio is approximately 1 is maintained. For that reason, the luminance of the screen 144 does not change but the size of the program current becomes larger so that the shortage of writing of a current program is improved.

While the duty ratio is lowered, the reference current ratio is also lowered in the high lighting rate region (lighting rate of 75 percent or more in FIG. 267). Therefore, A as duty ratio×reference current ratio is controlled to be closer to 0.25 as the lighting rate becomes higher. For that reason, as the lighting rate becomes high, the luminance of the screen 144 lowers and the consumption current also lowers. Therefore, the self heating value of the panel lowers in proportion to A×lighting rate.

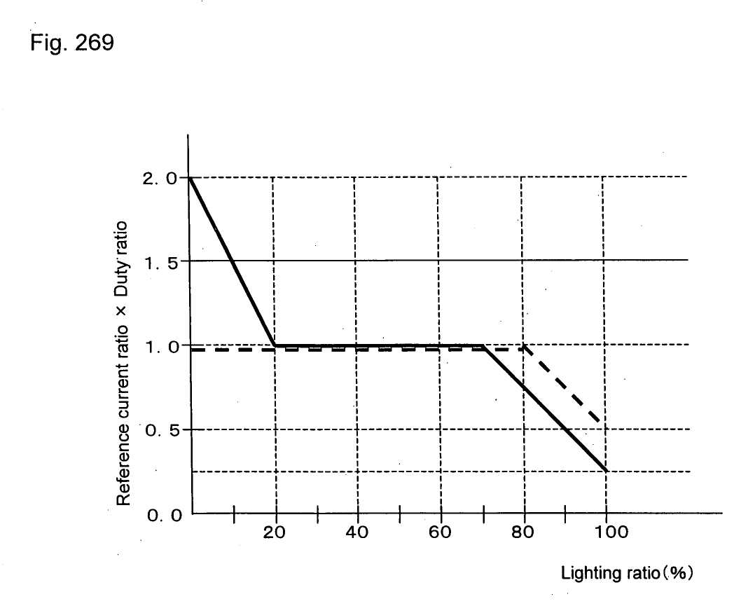

Generally, in the case where the EL display panel is a small to medium size of 15 inches or less, it is desirable to perform the driving in the relation indicated by a dotted line in FIG. 269 (to lower duty ratio×reference current ratio when the lighting rate is high). In the case where the EL display panel is a large size of 15 inches or more, it is desirable to perform the driving in the relation indicated by a full line in FIG. 269 (to lower duty ratio×reference current ratio when the lighting rate is high, and to increase duty ratio×reference current ratio when the lighting rate is low).

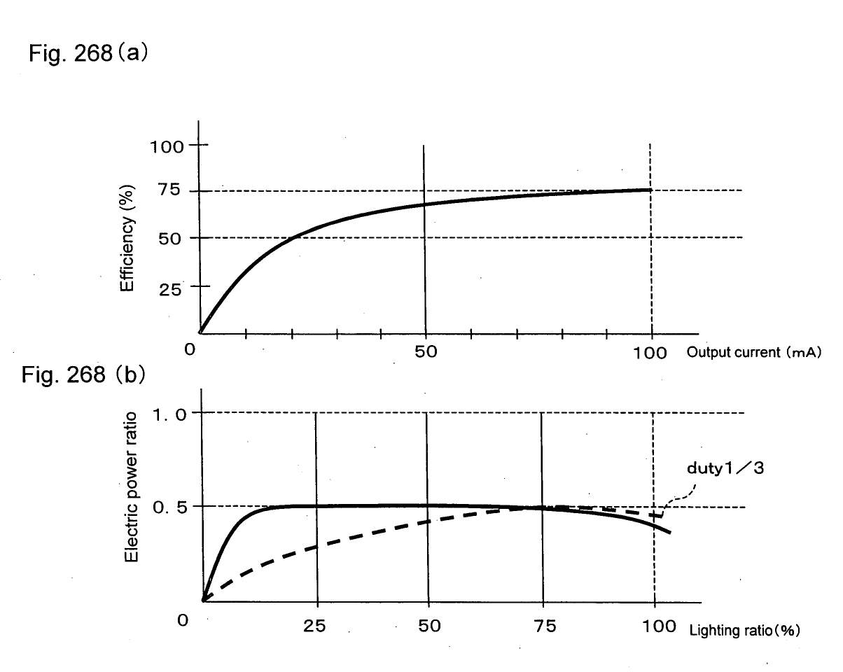

FIG. 268(a) shows an efficiency graph of a power supply circuit of the present invention. The efficiency is high when the output current is higher than middle. Therefore, it is desirable that the output current use a constant or higher output on average.

If the control is exerted as indicated by the dotted line in FIG. 269, a relative change ratio of the electric power (power ratio) is as indicated by the dotted line in FIG. 268(b). If the control is exerted as indicated by the full line in FIG. 269, the relative change ratio of the electric power (power ratio) is as indicated by the full line in FIG. 268(a). As for the full line, the electric power increases at the low lighting rate. However, the power consumption hardly increases because the lighting rate is low. The advantage of improving the shortage of writing is more significant.

If the duty ratio is ⅙ or more or preferably ¼ or more, it is desirable to insert the non-display areas 192 collectively (FIGS. 54(a1) to (a4) and so on). If the duty ratio is ⅙ or less or preferably less than ¼, it is desirable to insert the non-display areas 192 dividedly (FIGS. 54(b1) to (b4), (c1) to (c4) and so on).

The present invention changes the first FRC, lighting rate, current passing through the anode (cathode) terminal, reference current, duty ratio, panel temperature, product of the reference current ratio and duty ratio or a combination thereof at a first lighting rate (it may be the ratio to the anode current of the anode terminal or the sum total of the data as previously described) or in the lighting rate range (it may be the anode current range of the anode terminal or the range of the ratio to the sum total of the data as previously described).

Also, the present invention changes the second FRC, lighting rate, current passing through the anode (cathode) terminal, reference current, duty ratio, panel temperature, product of the reference current ratio and duty ratio or a combination thereof at a second lighting rate (it may be the ratio to the anode current of the anode terminal) or in the lighting rate range (it may be the anode current range of the anode terminal). That is, the present invention changes the FRC, lighting rate, current passing through the anode (cathode) terminal, reference current, duty ratio, panel temperature, product of the reference current ratio and duty ratio or a combination thereof according to (adjusting) a lighting rate (it may be the ratio to the anode current of the anode terminal) or in the lighting rate range (it may be the anode current range of the anode terminal). When changing them, they are changed with a hysteresis, with a delay or slowly.

The present invention described the pre-charge driving method. The concept of the lighting rate was also described. It is also effective to change the pre-charge voltage by the lighting rate.

The lighting rate is synonymous with the consumption current in the case of performing no duty ratio control. To be more specific, the lighting rate is derived by addition of the image data. It is because, in the case of the current driving, the image data is in proportion to the power consumption and so the lighting rate is derived from the image data.

The pre-charge driving is similar to voltage driving. It applies the voltage to a source signal line 18 and applies the pre-charge voltage to a gate voltage of a driving transistor 11a so as to prevent the driving transistor 11a from passing the current through the EL element 15. Therefore, a reference origin of the pre-charge voltage is an anode potential (Vdd). As a matter of course, the origin of the pre-charge voltage is the cathode in the case where the driving transistor is an N-channel. This specification describes the driving transistor 11a as a P-channel as shown in FIG. 1 to facilitate the description.

If the anode potential changes, the pre-charge voltage needs to be changed. The resistance value of an anode wiring 2155 is reduced so as not to change the anode potential (Vdd). In the case where the lighting rate is high, however, a voltage drop occurs because a large amount of current passes through the anode wiring (terminal). The voltage drop is in proportion to the consumption current. Therefore, the voltage drop of the anode voltage is in proportion to the lighting rate.

Thus, it is desirable to change the pre-charge voltage in correlation with the lighting rate. It is desirable, otherwise, to change the pre-charge voltage correspondingly to the current passing through the anode (cathode) terminal (or the current passing through the EL display panel).

A source driver circuit of the present invention has an electronic regulator 501 as shown in FIG. 75. Therefore, it is possible to change the pre-charge voltage easily by controlling the electronic regulator 501. It goes without saying that, in addition to controlling the electronic regulator 501, it is possible to generate the pre-charge voltage with a DA circuit outside a source driver circuit (IC) 14 and apply it.

It is possible to grasp the voltage drop occurring on the anode terminal by the following process. First, the resistance value from the source of the anode voltage to each pixel is known at the stage of design. It is because the resistance value is decided from a sheet resistance value of a metallic thin film of the anode wiring (resistance from the anode terminal to the driving transistor 11a of the pixel 16). The consumption current passing through the anode terminal can be known by processing the video data. The sum total of the video data should be acquired in the case of the current driving method. The above was described as derivation of the duty ratio, data sum and lighting rate in FIGS. 85, 88, 98, 103, 205, 107 and 109. As a major characteristic of the current program method, it is easy to derive the current passing through the anode.

Therefore, the voltage drop occurring to the anode terminal is known by acquiring the resistance value of the anode wiring and the current passing through the anode wiring (the consumption current of the panel). The consumption current is derived in real time by image data processing of one frame. Therefore, the voltage drop of the anode terminal on the pixel 16 is also decided in real time.

The anode voltage (considering the voltage drop) on the pixels 16 is derived considering the above, and the pre-charge voltage is decided in consideration of the voltage drop. The decision on the pre-charge voltage is not limited to a real-time decision. It goes without saying that it may also be intermittently performed. When performing the duty ratio control, the current passing through the anode changes according to the duty ratio. Therefore, it is necessary to add the consumption current due to the duty ratio control. In the case where the duty ratio is 1/1, the lighting rate is the same as the consumption current (electric power).

According to the present invention, exerting control to reduce the reference current ratio (or the size of the reference current) (change from the reference current ratio 4 to 1 for instance) is synonymous with or similar to exerting control to reduce the current passing through the cathode terminal or the current passing through the anode terminal or the current passing through the EL element 15 of the pixel 16. In the same way, exerting control to reduce the duty ratio (or the size of the duty) (change from the duty ratio 1/1 to ¼ for instance) is synonymous with or similar to exerting control to reduce the current passing through the cathode terminal or the current passing through the anode terminal or the current passing through the EL element 15 of the pixel 16.

Therefore, it is possible, by controlling a gate driver circuit (IC) 12 (controlling a start signal (ST) in FIG. 14 for instance), to implement the control to reduce or increase the current passing through the cathode terminal or the current passing through the anode terminal or the current passing through the EL element 15 of the pixel 16. It is possible, otherwise, to implement such control easily by having a control state of gate signal lines 17b (signal lines or control means of controlling the current passing through the EL element 15) (the number of the gate signal lines 17b to be selected) changed, adjusted or operated by the gate driver circuit (IC) 12. Also, it is possible, by controlling a gate driver circuit (IC) 14 (controlling a reference current Ic in FIG. 46, 50, 60, etc. ), to implement the control to reduce or increase the current passing through the cathode terminal or the current passing through the anode terminal or the current passing through the EL element 15 of the pixel 16. It is also possible to implement such control by changing or controlling the anode voltage Vdd.

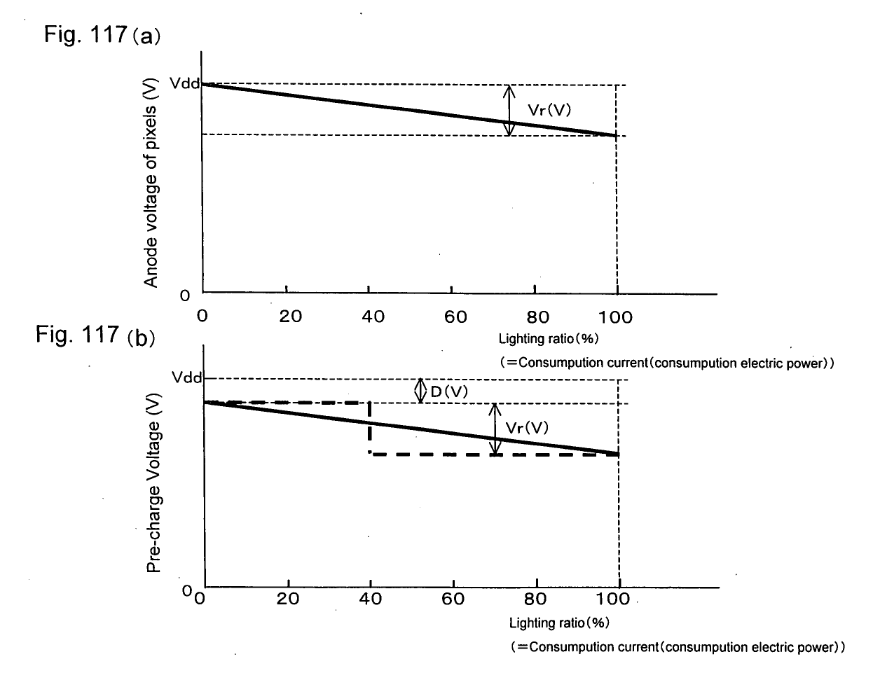

To facilitate the description, this specification basically gives a description on condition that the duty ratio is 1/1 in FIG. 117. To be more specific, the lighting rate is in proportion to the current passing through the anode.

The anode current is in proportion to the lighting rate according to the description. However, the program current flowing into a source driver IC is added to the anode terminal (source terminal of the driving transistor 11a) in the pixel configuration of FIG. 1. Therefore, it is a little different in reality. The description is given centering on the current passing through the anode wiring. However, it goes without saying that it may be replaced by the current passing through the cathode wiring.

FIG. 117(a) shows that the anode voltage on the pixels 16 has the voltage drop from Vdd (lighting rate 0%) to Vr (lighting rate 100%) occurring according to the lighting rate. FIG. 117(b) shows the pre-charge voltage outputted to a terminal 155 against the lighting rate. There is a startup position of the driving transistor 11a at the position descending from Vdd by D (V). Therefore, the voltage descending from Vdd by D (V) is the pre-charge voltage at the lighting rate of 0 percent. The full line in FIG. 117(b) is using the voltage drop Vr (V) of the anode terminal of FIG. 117 (a) as-is. Therefore, the pre-charge voltage of the lighting rate of 100 percent is Vdd−D−Vr.

The dotted line in FIG. 117(b) has the pre-charge voltage changed between the lighting rate of 40 percent or more and the lighting rate below 40 percent. The pre-charge voltage is Vdd−D (V) up to the lighting rate of 40 percent, and it is Vdd−D−Vr (V) at 40 percent or more. A derivation circuit of the pre-charge voltage is simplified by exerting control as indicated by the dotted line.

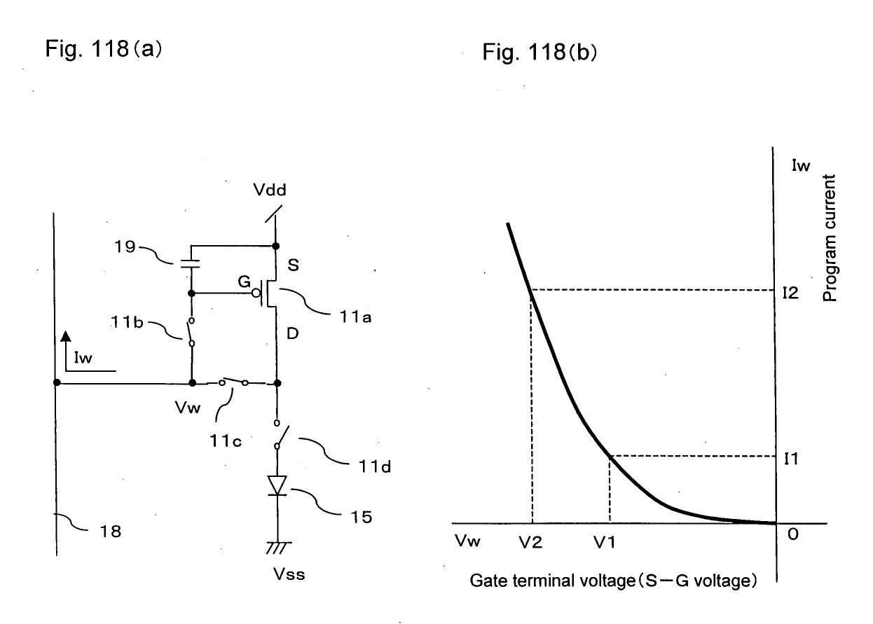

The anode voltage Vdd is dependent on the size of a program current Iw. A description will be given by showing the pixel configuration of FIG. 1. As shown in FIG. 118(a), the program current Iw flows into the source signal line 18 from the driving transistor 11a in the case of the current program. When the program current Iw is large, a channel-to-channel voltage of the driving transistor 11a becomes larger. FIG. 118(b) is a graph version of FIG. 118(a). A program current I1 flows at a channel-to-channel voltage V1 (0 of the horizontal axis is the voltage Vdd in reality). A program current I2 flows at a channel-to-channel voltage V2 (0 of the horizontal axis is the voltage Vdd in reality). It is necessary to enhance the anode voltage Vdd in order to pass the large program current Iw.

The embodiment described that it is necessary to increase the anode voltage Vdd if the program current Iw becomes large. Inversely, it means that the anode voltage Vdd may be low when the program current Iw is small. If the anode voltage Vdd becomes low, the power consumption of the panel can be reduced and the electric power consumed by the driving transistor 11a can also be reduced. Therefore, the heat generation can be reduced and life of the EL element 15 can be extended.

The program current Iw changes according to the change in the reference current. If the reference current Ic increases, the program current Iw becomes relatively large (discussing the case where the gradation data of the screen is constant, that is, a raster screen). If the reference current Ic decreases, the program current Iw also becomes relatively small. Here, a description will be given on condition that the increase or decrease in the program current Iw is synonymous with the increase or decrease in the reference current Ic to facilitate the description.

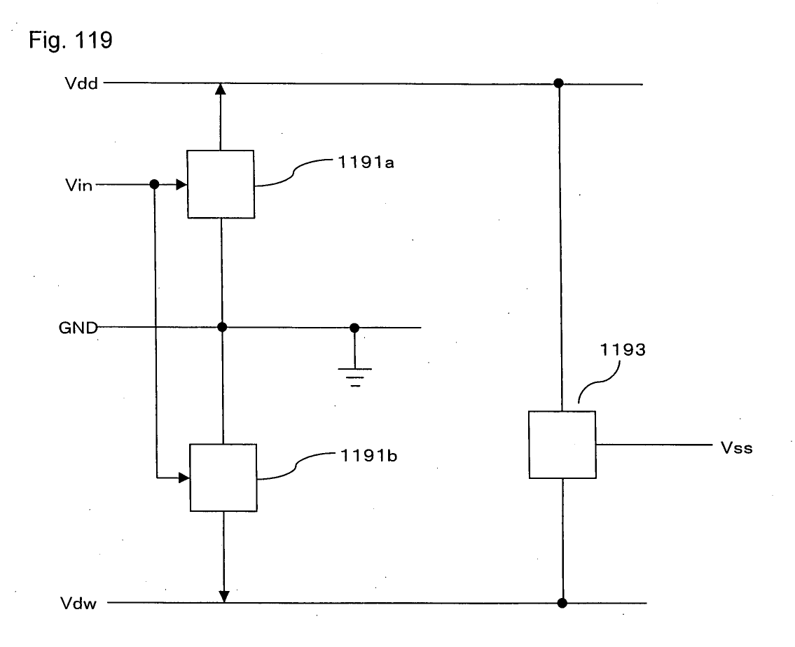

FIG. 119 is a block diagram of the power supply circuit of the present invention. Vin is an unregulator voltage from a battery (not shown) of the body. A DCDC converter 1191a increases the voltage from the voltage Vin to generate the anode voltage Vdd in reference to a GND voltage. A description will be given on condition that a power supply voltage Vs of the source driver IC is the same as the anode voltage Vdd to facilitate the description. The number of the power supplies decreases and the circuit configuration becomes easier on condition of Vdd=Vs. An overvoltage is no longer applied to the source driver IC. A DCDC converter 1191b increases the voltage from the voltage Vin to generate a base voltage Vdw in reference to the GND voltage.

A regulator 1193 generates the cathode voltage Vss from the voltages Vdw and Vdd with the voltage Vdd as a ground voltage. In the configuration, if the voltage Vdd rises, the voltage Vss also rises in proportion.

As is understandable from FIG. 1, a constant current Iw is generated by the driving transistor 11a, and the program current Iw passes through the EL element 15. Therefore, the power consumption is a potential difference between Vdd and Vss. In the configuration of FIG. 119, as the voltage Vdd shifts, the voltage Vss also shifts in the same direction. Therefore, even if the anode voltage changes, the voltage applied between the EL element 15 and the driving transistor 11a is constant.

As described in FIG. 118, it is necessary to increase the anode voltage when the program current Iw (reference current Ic) becomes large. It is because a GND potential is fixed. An IC voltage Vs is changed simultaneously with the change in the anode voltage (Vdd=Vs). If Vdd−Vss is a constant voltage and Vdd becomes high, the voltage applied to the EL element 15 becomes low. Therefore, the EL element 15 no longer operates in a saturation region. However, the region in which Iw (Ic) must become large is the region of the low lighting rate, where the pixels are under high luminance control. Therefore, even if the luminance of the pixel 16 of the low lighting rate and high luminance display lowers, the image display is hardly influenced. The power consumption as an advantage is more significant.

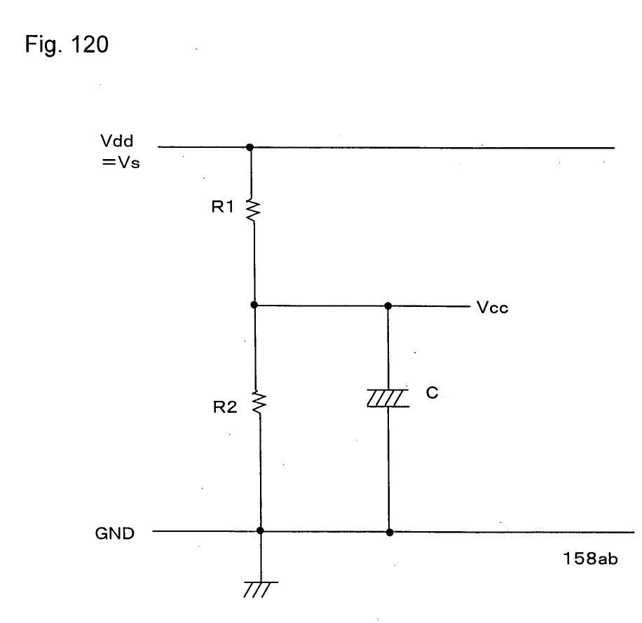

If not Vdd=Vs, it should be generated by dividing the resistors (R1, R2) between the anode voltage Vdd and GND as shown in FIG. 120. It is because the voltage Vs is used for generation of the pre-charge voltage inside the IC. As Vdd is the reference for the pre-charge voltage, Vs and Vdd need to work together. As shown in FIG. 120, an electrolytic capacitor C is inserted.

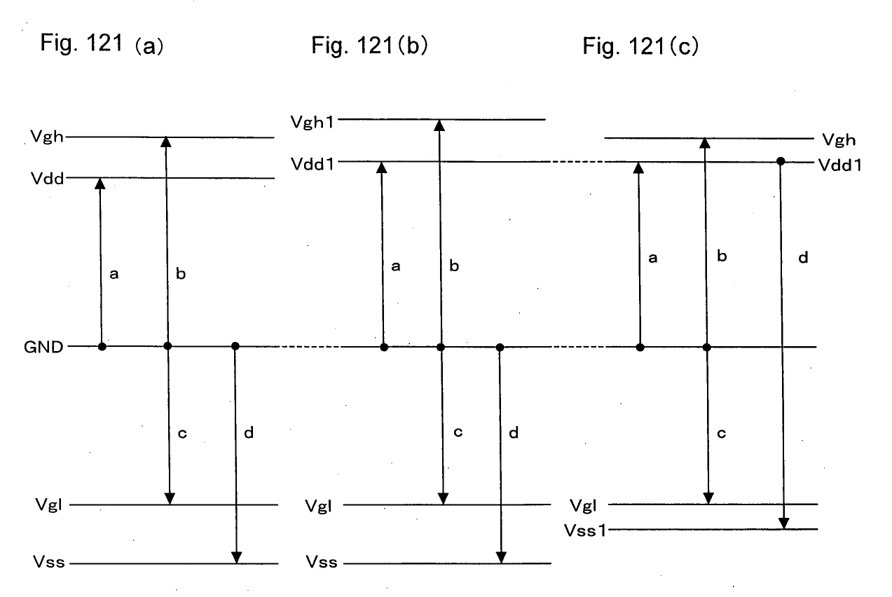

FIGS. 121 show the relation with a gate-off voltage (Vgh) and a gate-on voltage (Vgl) (also refer to FIG. 180 and the description thereof). In FIG. 121(a), the voltage Vgh is higher than the anode voltage Vdd. The voltage Vgl is higher than the voltage Vss.

FIG. 121(b) shows a state in which the anode voltage Vdd is shifted and rendered higher than a reference voltage Vdd (indicated as a voltage Vdd1). In FIG. 121(b), the voltage Vgh rendered high hand-in-hand with the change in Vdd. The voltage Vgl has not changed from FIG. 121(a).

FIG. 121(b) shows a state in which the anode voltage Vdd is shifted and rendered higher than a reference voltage Vdd (indicated as a voltage Vdd1). In FIG. 121(b), the voltage Vgh does not go hand-in-hand with the change in Vdd. The voltage Vgl has not changed from FIG. 121(a). As described above, it maybe either gate signal line voltages Vgh or Vgl.

It is desirable to render the anode voltage Vdd equal to the power supply voltage Vs (or the reference voltage) of the IC (circuit) 1A. It is also desirable to render the reference voltage Vs of the electronic regulator 501 for generating the pre-charge voltage equal to the anode voltage Vdd as shown in FIG. 75. To be more specific, circuit power supply voltage for generating the pre-charge, the power supply voltage (reference voltage) Vs of the IC (circuit) 14 and the anode voltage Vdd are approximately matched with one another. Approximately matching means a range within ±0.2 (V). It goes without saying that it is preferable to match them completely with one another, as a matter of course.

The reference voltage Vs of the electronic regulator 501 for generating the pre-charge voltage, the anode voltage Vdd and the power supply voltage Vs of the circuit (IC) 14 should work together. For instance, if the anode voltage Vdd rises, the reference voltage Vs of the electronic regulator 501 for generating the pre-charge voltage should also be increased. The power supply voltage of the circuit (IC) 14 should also be increased. Inversely, if the anode voltage Vdd lowers, the reference voltage Vs of the electronic regulator 501 for generating the pre-charge voltage should also be decreased. And the power supply voltage of the circuit (IC) 14 should also be decreased.

They should work together as above because it is desirable to generate the pre-charge voltage in reference to Vdd of the driving transistor 11a (that is, a source terminal potential of the driving transistor 11a). To be more specific, it is desirable that, if the anode voltage Vdd rises, the pre-charge voltage should also be increased in conjunction therewith. Therefore, the reference voltage Vs of the electronic regulator 501 (power supply voltage of the IC (circuit) 14) should also be increased. As the electronic regulator 501 is built into the source driver circuit (IC) 14, the electronic regulator 501 obviously cannot exceed the power supply voltage (withstand voltage) of the IC.

In reality, the pre-charge voltage which can be outputted from the source driver circuit (IC) 14 is the power supply voltage of the IC (circuit) 14-0.2 (V) or so. Therefore, if the pre-charge voltage rises, a target pre-charge voltage cannot be outputted from the IC (circuit) 14 unless the power supply voltage of the IC (circuit) 14 is also increased.

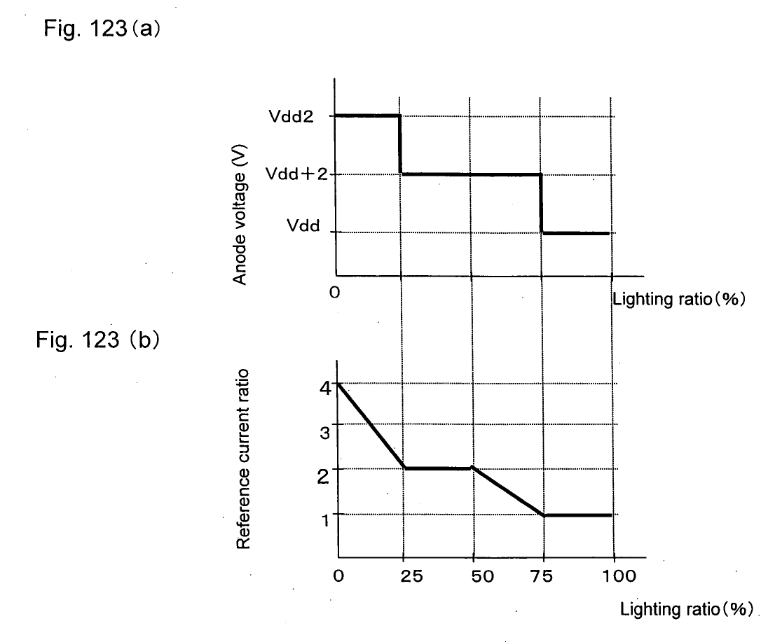

As shown in FIG. 75, the pre-charge voltage has a digitally variable (variable from outside the IC) configuration such as the electronic regulator 501. Therefore, it is possible to detect the change in the anode voltage Vdd (refer to FIGS. 123, 124 and 125 for instance) and change a switch S of the electronic regulator 501 so as to change the pre-charge voltage. Therefore, the configuration in FIG. 75 is a characteristic configuration as the IC (circuit) 14 of the present invention. The pre-charge voltage may also be generated outside the IC (circuit) 14 and applied to the source signal line 18 via the IC (circuit) 14. In this case, it is also necessary to render the power supply voltage Vs of the IC (circuit) 14 higher than the maximum value of the pre-charge voltage by 0.2 (V).

The embodiment described the pre-charge voltage. However, it goes without saying that it is not limited to the pre-charge voltage but is also applicable to a reset voltage described in FIG. 228.

It described that the anode voltage Vdd and the power supply voltage of the IC (circuit) 14 work together. However, in the case where the driving transistor 11a is N-channel as shown in FIGS. 9 and 10, the cathode voltage Vss is the reference. Therefore, it goes without saying that the reference voltage Vs of the electronic regulator 501 for generating the pre-charge voltage, the cathode voltage Vss and the power supply voltage Vs (or a GND level) of the circuit (IC) 14 should work together. Therefore, the contents described above should be replaced.

It goes without saying that the above is also applicable to the display panel, display apparatus and driving method as the other embodiments of the present invention.

FIG. 122 shows the relation between the lighting rate and the anode voltage as an example. Vdd+2 and Vdd+4 do not indicate absolute voltages but are relatively shown in order to facilitate the description.

In FIG. 122, the reference current (program current) is increased at the lighting rate of 25 percent or less. In this state, it is necessary to increase the anode voltage, and so the anode voltage is increased along with the increase in the reference current. The reference current is increased at the lighting rate of 75 percent or more. And the anode voltage is also increased along with the increase in the reference current.

FIG. 122 shows the relation between the lighting rate and the anode voltage as an example. The present invention is not limited thereto. For instance, it goes without saying that, as shown in FIG. 280, the potential difference between the anode terminal voltage and the cathode terminal voltage may be changed according to the lighting rate. For instance, if the anode terminal voltage is 6 (V) and the cathode terminal voltage is −9 (V), the potential difference is 6−(−9)=15 (V). To be more specific, absolute values of the anode voltage and cathode voltage are changed according to the lighting rate, the reference current or the current passing through the anode terminal.

A full line A in FIG. 280 indicates the potential difference between the first anode terminal voltage and cathode terminal voltage as the first lighting rate or lighting rate range, and also indicates the potential difference between the second anode terminal voltage and cathode terminal voltage as the second lighting rate or lighting rate range. It also changes the anode terminal voltage and cathode terminal voltage according to the lighting rate from the first lighting rate or lighting rate range to the second lighting rate or lighting rate range. It goes without saying that only one of the anode terminal voltage and cathode terminal voltage may be changed, as a matter of course.

A dotted line B in FIG. 280 indicates the potential difference between the first anode terminal voltage and cathode terminal voltage at the first lighting rate or lighting rate range, and also indicates the potential difference between the second anode terminal voltage and cathode terminal voltage at the second lighting rate or lighting rate range so as to make a stepwise change.

By way of example, it is possible, by having the configurations in FIG. 602 to 604, to change or control the anode voltage program-wise with control signal DATA. The DATA is digital data which changes according to the lighting rate. To be more specific, a variable of the DATA is the lighting rate.

In FIG. 602, the anode terminal of the driving transistor 11a for driving each pixel 16 is connected to an output terminal b of an operational amplifier 502. An a-terminal output voltage of the electronic regulator 501 changes according to the DATA. The a-terminal voltage is applied to the operational amplifier 502 so as to control (change) the anode voltage. It goes without saying that the above configuration is also applicable to the case of changing the cathode voltage.

In FIG. 603, the pixel 16 is the pixel configuration of a current mirror. It goes without saying that the method of FIG. 602 is applicable even to the pixel configuration of the current mirror. FIG. 604 is configured to have an inverter circuit in the pixel 16. It goes without saying that the method of FIG. 602 is also applicable to the pixel configuration of FIG. 604.

A description will be given centering on the pixel configuration of FIG. 1 as to the configuration or method of the present invention described in this specification such as lighting rate control. However, the present invention is not limited thereto. It goes without saying that it is also applicable to the other pixel configurations such as FIGS. 602, 603 and 604.

One of the characteristics of the embodiments of the present invention is that the duty ratio is changed correspondingly to the lighting rate and so on. The duty ratio may also be changed correspondingly to the change in the number of scanning lines of the display panel (number of image display pixel lines). FIG. 515 is an embodiment thereof. Change in the number of display pixels means that the display area changes. The smaller the display area is, the more the electric power consumed by the display panel changes. To be more specific, if the number of scanning lines increases, the display area becomes larger so that the electric power consumed by the display panel increases. Inversely, if the number of scanning lines decreases, the display area becomes smaller so that the electric power consumed by the display panel decreases.

One of the objects in performing the duty ratio control in the present invention is to keep the power consumption from becoming a certain level or higher and render it even. Therefore, a difference in the increase in the number of scanning lines lowers the duty ratio. When the number of scanning lines decreases, the duty ratio may be large. The duty ratio is also changed according to the lighting rate whether the number of scanning lines increases or decreases.

The full line in FIG. 515 indicates the case where the number of scanning lines is 200. The duty ratio is 1/1 at the lighting rate of below 40 percent, and is reduced at the lighting rate of 40 percent or more. The dotted line indicates the case where 220 scanning lines are displayed on the same display panel as that in full line. The duty ratio is ⅞ at the lighting rate of below 40 percent, and is reduced at the lighting rate of 40 percent or more. The one-dot-dash line indicates the case where 240 scanning lines are displayed on the same display panel as that in full line. The duty ratio is ¾ at the lighting rate of below 40 percent, and is reduced at the lighting rate of 40 percent or more.

The embodiment has the duty ratio variable correspondingly to the number of scanning lines. However, the present invention is not limited to this. For instance, it is possible to change the reference current ratio correspondingly to the number of scanning lines. The reference current ratio should be large when the number of scanning lines is small, and it should be small when the number of scanning lines is relatively or absolutely large.

The embodiment changed the duty ratio and so on correspondingly to the number of scanning lines. It is also possible to change the duty ratio and so on correspondingly to the panel or the ambient temperature of the panel. FIG. 516 is and embodiment thereof. The full line in FIG. 516 indicates the case where the panel temperature is below 40° C. The full line indicates the case where the duty ratio is 1/1 at the lighting rate of below 40 percent, and is reduced at the lighting rate of 40 percent or more. The dotted line indicates the case where the duty ratio is ½ at the lighting rate of below 20 percent, and is reduced at the lighting rate of 20 percent or more. The curve between the dotted line and the full line is drawn between 40 and 60° C.

Likewise, it is possible to change the reference current ratio correspondingly to the temperature as shown in FIG. 517. It is also possible, as a matter of course, to change both the duty ratio and the reference current ratio. The full line in FIG. 517 indicates the case where the panel temperature is below 40° C. The full line indicates the reference current ratio as 1/1 at the lighting rate of below 40 percent, and lowers the reference current ratio at 40 percent or more. The dotted line is the case of 60° C., where the reference current ratio is 3 at the lighting rate of below 20 percent and is reduced at the lighting rate of 20 percent or more. The curve between the dotted line and the full line is drawn between 40 and 60° C. It is also possible, as a matter of course, to change the reference current ratio to multiple values according to the lighting rate as indicated by the dotted line. It is also possible, as in FIG. 518, to change duty ratio×reference current ratio according to the lighting rate.

In FIG. 123, the reference current (program current) is changed stepwise according to the lighting rate. The anode voltage is also changed along with the change in the reference current.

In FIGS. 119, 123 and 280, the anode voltage is changed according to the change in the reference current (program current). However, this is the case where the driving transistor 11a is P-channel. It goes without saying that the cathode voltage is changed in the case of the N-channel.

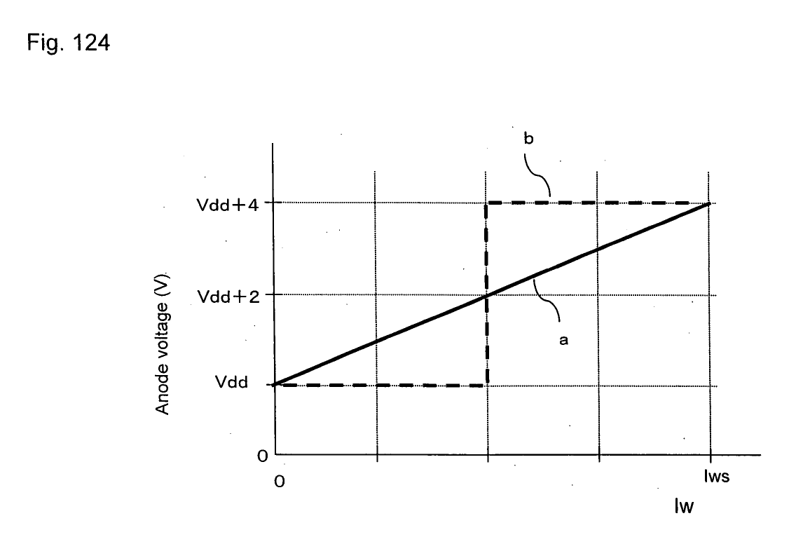

The anode voltage may be changed against the size of the program current (reference current) as shown in FIG. 124. A full line a in FIG. 124 is an example in which the anode voltage is changed in proportion to the program current (reference current). A dotted line b in FIG. 124 is an example in which the anode voltage is changed at a predetermined program current (reference current) or more. As for the dotted line b, the circuit configuration is easier because there is only one point of variation of the anode voltage against the reference current.

In FIGS. 119 and 120, it goes without saying that it is possible to form or configure a boosting circuit by using a transformer (auto or compound-wound transformer) or a coil instead of the DCDC converter or a regulator.

The embodiment changed the anode voltage according to the size of the reference current or the program current. However, the change in the size of the reference current or the program current is synonymous with the change in the potential of the source signal line 18. In the case where the driving transistor 11a of FIG. 1 is P-channel, increasing the program current Iw or the reference current means lowering the potential of the source signal line 18 (closer to the GND potential) Inversely, decreasing the program current Iw or the reference current means increasing the potential of the source signal line 18 (closer to the anode Vdd).

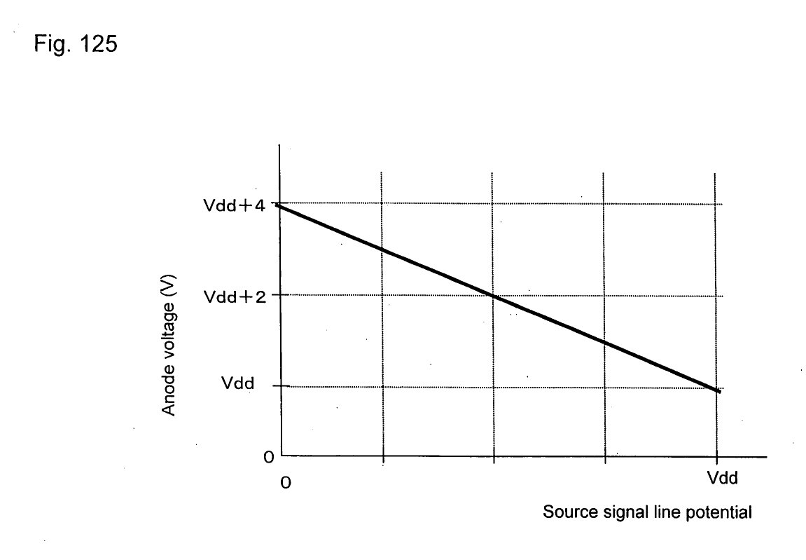

Thus, it is possible to exert control as shown in FIG. 125. To be more specific, the anode voltage should be the highest (the reference current and the program current are at the maximum values) when the potential of the source signal line 18 is 0 (GND) potential. When the potential of the source signal line 18 is the potential Vdd, the anode voltage should be the lowest (the reference current and the program current are at the minimum values). It is possible, by means of the above configuration or control, to reduce the period for applying a high voltage to the EL element 15 so as to extend the life of the EL element 15.

Hereunder, a further description will be given as to the power supply circuit (voltage generation circuit) of the EL display panel (EL display apparatus) of the present invention.

A description will be given as to the power supply circuit of an organic EL display apparatus of the present invention. FIG. 539 is a block diagram of the power supply circuit of the present invention. Reference numeral 5392 denotes a control circuit. The control circuit 5392 controls a midpoint potential between resistors 5395a and 5395b, and outputs a signal for controlling the gate terminal of a transistor 5396. A power supply Vpc is applied to a primary side of a transformer 5391, and the current on the primary side is conveyed to a secondary side by on and off control of the transistor 5396. Reference numeral 5393 denotes a rectifier diode, and 5394 denotes a smoothing condenser.

An organic EL display panel of the current driving method has the following characteristic from a viewpoint of the potential. As for the pixel configuration of the present invention, the driving transistor 11a is a P-channel transistor as described in FIG. 1. A unit transistor 154 of the source driver circuit (IC) 14 for generating the program current is an N-channel transistor. According to this configuration, the program current is an absorption current (sink current) flowing from the pixel 16 to the source driver circuit (IC) 14. Therefore, it operates potential-wise with the anode (Vdd) as its origin. To be more specific, the program to the pixel 16 is the current, and so the potential of the source driver circuit (IC) 14 may be any value once a voltage margin of the driving is secured.

The control circuit 5392 is controlled by a logic signal (GND-VCC voltage) from a logic circuit of the controller 760. Therefore, it is necessary to match the control circuit 5392 with the ground (GND) of the logic circuit. However, the transformer 5391 has an input side separated from an output side. The source driver circuit (IC) 14 of the current program method acts on the output side, and operates in reference to the anode potential (Vdd). Therefore, it is not necessary to match the ground (GND) of the source driver circuit (IC) 14 with the grounds of the control circuit 5392 and the logic circuit. On this point, there is a synergic effect in the combination of the source driver circuit (IC) 14 of the current program method, generation of the anode voltage (Vdd) by using the transformer 5391 (in addition, generation of the cathode voltage (Vss) in reference to the anode voltage (Vdd)) and the driving transistor 11a of the pixel 16 being P-channel.

The organic EL display panel operates at the absolute values of the anode (Vdd) and cathode (Vss). For instance, if Vdd=6 (V) and Vss=−6 (V), it operates at 6−(−6)=12 (V). As for the power supply circuit using the transformer 5391 of the present invention in FIG. 539, the cathode voltage (Vss) changes in reference to the anode (Vdd). The anode voltage (Vdd) is a reference position of the program current of the source driver circuit (IC) 14 of the current driving of the present invention. To be more specific, it operates with the anode voltage (Vdd) as its origin.

Inversely, the potential or control of the cathode voltage (Vss) may be rough. For this reason, there is a synergic effect in the combination of the power supply circuit of the present invention using the transformer in FIG. 539, the organic EL display panel having the current-driven pixel 16 configuration and the source driver circuit (IC) 14 of the current program method. It is also important that the cathode voltage shifts due to the change in the anode voltage.

Theoretically, the organic EL display panel has an approximate match between a current Idd flowing into the driving transistor 11a from the anode Vdd and a current Iss flowing into the cathode Vss from the EL element 15. To be more specific, there is a relation of Idd=Iss. It is Idd>Iss in reality, where the difference is slight and negligible because it is the program current of the source driver circuit (IC) 14. The transformer 5391 of FIGS. 539 and 540 has a match between the current outputted from the anode Vdd and the current absorbed from the cathode Vss due to its configuration. On this point, there is a great synergic effect in the combination of the organic EL display panel and the power supply circuit using the transformer 5391 of the present invention.

In the case of rendering the transistor 11a for driving the pixel 16 as the N-channel transistor, it goes without saying that the unit transistor 154 of the source driver circuit (IC) 14 can have the same effect if rendered as the P-channel transistor.

It is efficient to generate the voltage Vgh and voltage Vgl of a gate driver circuit 12 and the power supply voltage of the source driver circuit from the cathode voltage (Vss) and (or) anode voltage (Vdd). The transformer 5391 may have a 4-terminal configuration of 2 input terminals and 2 output terminals. It is preferable, however, to have 2 input terminals and 3 output terminals including a midpoint as shown in FIG. 539. The transformer 5391 may be an auto transformer (coil).

The power supply Vpc is applied to the primary side of the transformer 5391, and the current on the primary side is conveyed to the secondary side by on and off control of the transistor 5396. Reference numeral 5393 denotes a rectifier diode, and 5394 denotes a smoothing condenser. The size of the anode voltage Vdd is adjusted by the size of the resistor 5395b. Vss is the cathode voltage. The cathode voltage Vss is configured to be able to select and output two voltages as shown in FIG. 541. Selection of the two voltages is performed by a switch 5411. As for generation of the two voltages (−9 (V) and −6 (V) in FIG. 541) as the cathode voltages, they can be generated easily by providing an intermediate tap on the output side of the transformer 5391.

The two voltages can also be generated easily by configuring two windings for −9 (V) and −6 (V) on the output side of the transformer 5391 and selecting one of the windings. This point is also an advantage of the present invention. The present invention is also characterized by switching the cathode voltage (Vss) in FIG. 541. If the anode is changed, as the origin of the potential, the circuit configuration becomes complicated and so the cost becomes high.

The cathode voltage (Vss) does not influence the image display (is insensitive) even if a potential error of 10 percent or so arises. Therefore, as fine characteristics of the present invention, the cathode voltage is set in reference to the anode voltage and the cathode voltage (Vss) is changed according to a temperature characteristic of the panel. The transformer 5391 changes the ratio between the number of input windings and the number of output windings to change the cathode voltage and the anode voltage easily, which is very advantageous. It is also very advantageous to be able to change the anode voltage (Vdd) by changing a switching state of the transistor 5396. In FIG. 541, −9 (V) is selected by a switch 1781.

In FIG. 541, the cathode voltage Vss is selected from two voltages. However, it is not limited thereto. It may also be more than two. And the cathode voltage can be continuously changed by using a variable regulator circuit.

Selection of the switch 5411a and switch 5411b depends on the output result from the temperature sensor 4441. When the panel temperature is low, −9 (V) is selected as the voltage Vss. When at a certain panel temperature or higher, −6 (V) is selected. This is because the EL element 15 has a temperature characteristic and so the terminal voltage of the EL element 15 becomes higher on a low-temperature side. In FIG. 541, one voltage is selected from two voltages as Vss (cathode voltage). However, it is not limited thereto. It may also be composed to select a Vss voltage from more than three voltages. The above is also applicable to Vdd. As another characteristic configuration of the present invention, the cathode voltage (Vss) is lowered when below a certain temperature (a differential voltage between Vdd and Vss is increased if it becomes a low temperature).

In FIG. 541, the cathode voltage is switched (changed) by the temperature sensor 4441. However, it is not limited thereto. For instance, it is possible, as shown in FIG. 540, to form or place a variable resistor (posistor or thermistor) 5401 in parallel or in series with the resistor 5395 for deciding the output voltage so as to change the resistance values 5401 according to the temperature. This configuration changes an input voltage to an IN terminal of the control circuit 5392 so that the voltage Vdd or the voltage Vss can be adjusted to a proper value.

It is possible, as shown in FIG. 541, to detect the panel temperature and render multiple voltages selectable according to a detection result so as to reduce the power consumption of the panel. It just requires the voltage Vss to be reduced at a certain temperature or less. In general, an inter-terminal voltage of the EL element 15 becomes higher if the temperature becomes low. It is possible, at normal temperature, to use Vss=−6 (V) of which voltage is low.

The switches 5411 may be configured as shown in FIG. 541. It is easily feasible to generate multiple cathode voltages Vss by taking the intermediate tap out of the transformer 5391 in FIG. 541. This is also applicable to the case of the anode voltage Vdd. The configuration of FIG. 542 is shown as an embodiment. In FIG. 542, multiple cathode voltages are generated by using the intermediate tap of the transformer 5391.

FIG. 543 is a schematic diagram of potential setting. To facilitate the description of this example, it will be described on condition that the source driver circuit (IC) 14 is in reference to GND. The power supply of the source driver circuit (IC) 14 is Vcc. Vcc may match with the anode voltage (Vdd). The present invention sets it as Vcc<Vdd from the viewpoint of the power consumption. It is desirable that the voltage Vcc of the source driver circuit (IC) satisfy the relation of Vdd−1.5 (V)≦Vcc≦Vdd. If Vdd=7 (V) for instance, it is desirable that Vcc satisfy the condition of Vdd−1.5=5.5 (V) to 7 (V).

The off voltage Vgh of the gate driver circuit 12 should be the voltage Vdd or higher. It is desirable to satisfy the relation of Vdd+0.2 (V)≦Vgh≦Vdd+2.5 (V). If Vdd=7 (V) for instance, Vgh is set to satisfy the condition of 7+0.2=7.2 (V) to 7+2.5=9.5 (V). The above conditions are applied to both a pixel selection side (transistors 11b and 11c in the pixel configuration of FIG. 1) and an EL selection side (a transistor 11d in the pixel configuration of FIG. 1).

It is desirable that the on voltage Vgl of switching transistors (the transistors 11b and 11c in the pixel configuration of FIG. 1) for generating a route of the program current with the driving transistor 11a satisfy the condition of Vdd−Vdd to Vdd−Vdd−4 (V) or approximately match with the cathode voltage Vss. The same applies to the on voltage on the EL selection side (the transistor 11d in the pixel configuration of FIG. 1). To be more specific, if the anode voltage is 7 (V) and the cathode voltage is −6 (V), it is desirable that the on voltage Vgl be in the range of 7−7 (V)=0 (V) to 7−7−4=−4 (V). Or else, it is desirable that the on voltage Vgl approximately match with the cathode voltage to be −6 (V) or in proximity thereto.

In the case where the transistor 11a for driving the pixel 16 is the N-channel transistor, Vgh becomes the on voltage. It goes without saying that the off voltage should be replaced by the on voltage in this case.

One of the problems of the power supply circuit of the present invention is that the voltages Vgh and Vgl are generated from the anode voltage Vdd and (or) the cathode voltage Vss. The anode voltage is generated by the transformer 5391, and the voltages Vgh and Vgl are applied to the DCDC converter from this voltage.

However, Vgh and Vgl are control voltages of the gate driver circuit 12. Unless this voltage is applied, the transistors 11 of the pixel are put in a floating state. Without the voltage Vcc, the source driver circuit (IC) 14 is also put in the floating state so as to malfunction. Therefore, it is necessary, as shown in FIG. 544, to apply the voltages Vdd and Vss concurrently with, or when time Tl elapses after, applying the voltages Vgh, Vgl and Vcc to the panel.

The present invention solves the problem by means of the configuration shown in FIGS. 545. In FIGS. 545, reference numeral 5413a denotes a power supply circuit comprised of the transformer 5391 and so on. Reference numeral 5413b denotes the power supply circuit for inputting the voltage from the power supply circuit 5413a and generating the voltages Vgh, Vgl and Vcc, and is comprised of the DCDC converter circuit, regulator circuit and so on. Reference numeral 5451 denotes switches. A thyristor, a mechanical relay, an electronic relay, a transistor and an analog switch are applicable.

In FIGS. 545(a), the power supply circuit 5413a generates the anode voltage (Vdd) and cathode voltage (Vss) first. On this generation, the switch 5451a is in an openstate. Therefore, the anode voltage (Vdd) is not applied to the display panel. The anode voltage (Vdd) and cathode voltage (Vss) generated by the power supply circuit 5413a are applied to the power supply circuit 5413b, and the voltages Vgh, Vgl and Vcc are generated by the power supply circuit 5413b to be applied to the display panel. After applying the voltages Vgh, Vgl and Vcc to the display panel, the switch 5451a is turned on (closed) and the anode voltage (Vdd) is applied to the display panel.

In FIGS. 545(a), only the anode voltage (Vdd) is interrupted by the switch 5451a. It is because, if the anode voltage (Vdd) is not applied, the route for applying the current to the EL element 15 is not generated and the route for flowing into the source driver circuit (IC) 14 is not generated, either. Therefore, the display panel neither malfunctions nor performs floating operation.

As shown in FIGS. 545(b), it is possible, as a matter of course, to control the voltage applied to the display panel by on-and-off controlling both the switches 5451a and 5451b. However, it is necessary to exert control to either put the switches 5451a and 5451b in a closed state at the same time or put the switch 5451b in a closed state after closing the switch 5451a.

The above is the configuration in which the switches 5451 are formed or placed on a Vdd terminal of the power supply circuit 5413a. FIG. 546 shows the configuration in which no switch 5451 is formed or placed. The anode voltage (Vdd) borders on the voltage Vgh, and the anode voltage (Vdd) borders on the voltage Vcc, leveraging that, if the voltage Vgh is applied, the off voltage Vgh is applied to the gate signal lines 17a and 17b by the gate drivers 12 so as to put the transistors 11 (the transistors 11b, 11c and 11d in the configuration of FIG. 1) in the off state. If the transistors 11 are in the off state, a current route flowing from the driving transistor 11a to the EL element 15 is not generated and the route of the program current flowing from the driving transistor 11a into the source driver circuit (IC) 14 is not generated, either. Therefore, the display panel neither malfunctions nor performs abnormal operation.

If the anode voltage (Vdd) borders on the voltage Vgh, almost no current flows in the resistor even if shorted by a resistor 5461a. Therefore, a power loss hardly occurs. For instance, if the anode voltage (Vdd)=7 (V) and Vgh=8 while the resistor 5461a is 10 (KΩ), it makes (8−7)/10=0.1 and so the current passing through the resistor 5461a is 0.1 (mA).

Vgh is the off voltage. As it is the voltage outputted from the gate driver circuits 12, the current to be used is small. The present invention uses this property. To be more specific, it is possible to keep the gate signal lines 17 at the off voltage (Vgh) or the potential in proximity thereto with the resistor 5461a having shorted the anode voltage (Vdd) terminal and the Vgh terminal.

Therefore, a current route flowing from the anode voltage (Vdd) to the EL element 15 is not generated and the display panel performs no abnormal operation. It goes without saying that control is exerted to operate shift registers 141 (refer to FIG. 14) of the gate drivers 12 and output the off voltage (Vgh) from all the gate signal lines 17.

Thereafter, the power supply circuit 5413b operates completely and the prescribed voltage Vgh, voltage Vgl and voltage Vcc are outputted from the power supply circuit 5413b.

Likewise, if the anode voltage (Vdd) borders on the voltage Vcc, almost no current flows in the resistor even if shorted by a resistor 5461b. Therefore, the power loss hardly occurs. For instance, if the anode voltage (Vdd)=7 (V) and Vcc=6 (V) while the resistor 5461a is 10 (KΩ), it makes (7−6)/10=0.1 and so the current passing through the resistor 5461b is 0.1 (mA). Vcc is the voltage used in the source driver circuit (IC) 14. The current consumed from Vcc is used in a shift register circuit of the source driver circuit (IC) 14, which is a small amount.

The present invention uses this property. To be more specific, it is possible to put a switch 481 of the source driver circuit (IC) 14 in the off (open) state with the resistor 5461b having shorted the anode voltage (Vdd) terminal and the Vcc terminal so as not to have the current flow into the unit transistor 154. Therefore, a current route flowing from the anode voltage (Vdd) to the source signal line 18 is not generated and so the display panel performs no abnormal operation. It goes without saying that control is exerted to operate the shift registers of the source driver circuit (IC) 14 and separate the current route of the unit transistor 154 from all the gate signal lines 17.

In FIG. 546, it is also possible to short the cathode voltage (Vss) terminal and the Vgl terminal with the resistor (not shown). Because of this shorting of the resistor, the cathode voltage (Vss) is applied to the Vgl terminal on generation of the cathode voltage (Vss). Therefore, the gate driver circuit 12 operates normally.

It is described that the Vgh terminal is shorted by the resistor 5461 at the anode voltage (Vdd) in FIG. 546. It goes without saying that, in the case where the driving transistor 11a is the N-channel transistor, the anode voltage (Vdd) and the Vgl terminal are shorted or the cathode voltage (Vss) and the Vgl terminal are shorted.

It is described that the anode voltage (Vdd) and the Vgh voltage or the anode voltage (Vdd) and the Vcc voltage are shorted (connected) at a relatively high resistance. However, it is not limited thereto. It is also possible to replace the resistor 5461 with the switch such as the relay or analog switch. To be more specific, the relay is put in the closed state on generation of the anode voltage (Vdd). Therefore, the anode voltage (Vdd) is applied to the Vgh terminal and the Vcc terminal. Next, on generation of the voltage Vgh, voltage Vgl and voltage Vcc in the power supply circuit 5413b, the relay is put in the open state and the anode voltage (Vdd) is separated from the Vgh terminal and also separated from the Vcc terminal.

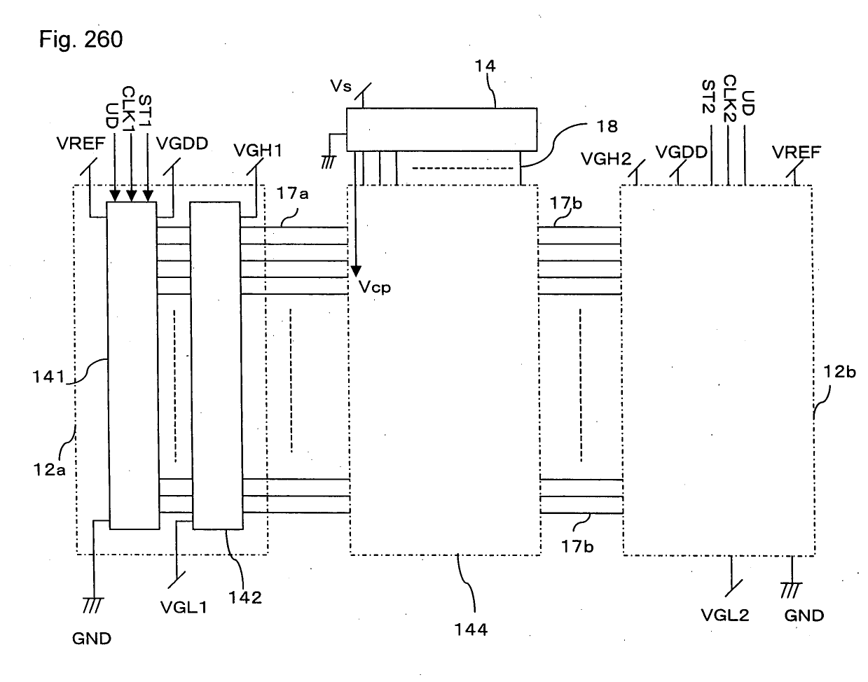

Next, a description will be given by using FIG. 260 as to the power supply (voltage) used for the EL display panel of the present invention. As described in FIG. 14, the gate driver circuit 12 is comprised of a buffer circuit 142 and a shift register circuit 141. The buffer circuit 142 uses the off voltage (Vgh) and the on voltage (Vgl) as the power supply voltage. The shift register circuit 141 uses a power supply VGDD of the shift register and a ground (GND) voltage, and also uses a VREF voltage for generating an inversion signal of an input signal (CLK, UD, ST). The source driver circuit (IC) 14 uses the power supply voltage Vs and the ground (GND) voltage.

Here, a voltage value will be prescribed in order to facilitate understanding. First, the anode voltage Vdd is 6 (V), and the cathode voltage Vss is −9 (V) (refer to FIG. 1). The GND voltage is 0 (V), and the Vs voltage of the source driver circuit is 6 (V) which is equal to the Vdd voltage. It is desirable that the Vgh1 and Vgh2 voltages are 0.5 (V) to 3.0 (V) from Vdd. Here, Vgh1=Vgh2=8 (V).

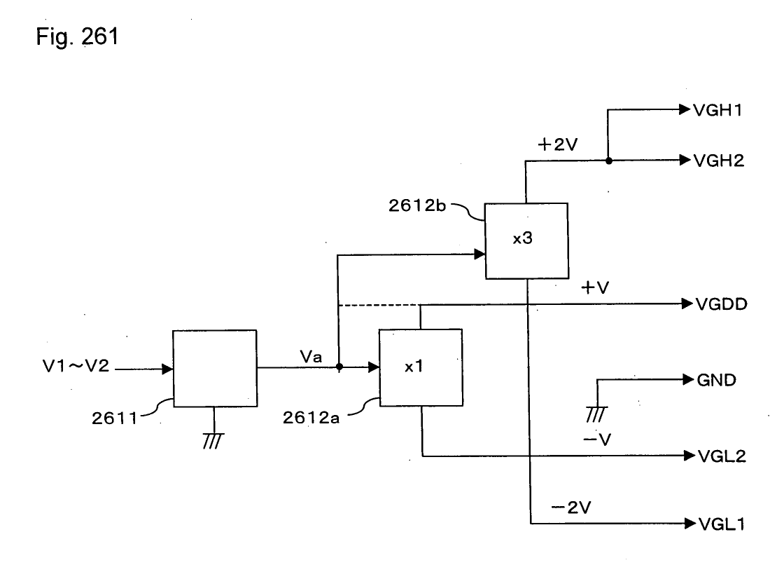

Vgh1 of the gate driver circuit 12 should be low in order to render on-resistance of the transistor 11c of FIG. 1 small enough. Here, it is Vgl1=−8 (V) of which absolute value is reverse to Vgh1 in order to facilitate the circuit configuration of FIG. 261. The VGDD voltage needs to be lower than Vgh and higher than the GND voltage. Here, it is 4 (V) which is ½ of the Vgh voltage in order to facilitate a generated voltage circuit and reduce circuit costs as in FIG. 261. As for a Vgl2 voltage, there is a danger of causing a leak of the transistor 11b if too low. Therefore, it should desirably be an intermediate voltage between the VGDD voltage and the VGLL voltage. Here, it is −4 (V) of which absolute value is equal to the VGDD voltage and polarity is reverse in order to facilitate the generated voltage circuit and reduce the circuit costs as in FIG. 261.

FIG. 261 shows the circuit configuration of the present invention for generating the voltage set up as above. Hereunder, a description will be given as to FIG. 261.

Voltages V1 to V2 from the battery are inputted to a regulator circuit 2611 having a charge pump circuit. To be more precise, V1=3.6 (V) and V2=4.2 (V). The regulator circuit 2611 converts the inputted voltage to a constant voltage Va of 4 (V) in a charge pump circuit 2612a. This voltage becomes the VGDD voltage. As a matter of course, it is also possible, as shown in FIG. 261, to generate 4 (V) which is +V and −4 (V) which is −V in the charge pump circuit (with no regulator function) 2612a for generating a positive voltage and a negative voltage. The −4 (V) becomes the Vgl2 voltage. The charge pump circuit 2612a only generates the voltages in positive and negative directions of Va, and so the configuration is very easy. Therefore, it is possible to realize reduction in the costs.

The output voltage Va from the regulator circuit 2611 is inputted to a charge pump circuit 2612b. It is also possible, as shown in FIG. 261, to generate 8 (V) which is +2V and −8 (V) which is −2V in the charge pump circuit (with no regulator function) 2612b for generating a positive voltage and a negative voltage. The −8 (V) becomes the Vgh1 and the Vgh2 voltages. The −2(V) voltage becomes the Vgl1 voltage. The charge pump circuit 2612b only generates the twice larger voltages in positive and negative directions than Va, and so the configuration is very easy. Therefore, it is possible to realize reduction in the costs.

As described above, the present invention is characterized by generating the Vgh voltage and so on by multiplying the reference voltage Va by a constant number (twice, three times and so on).

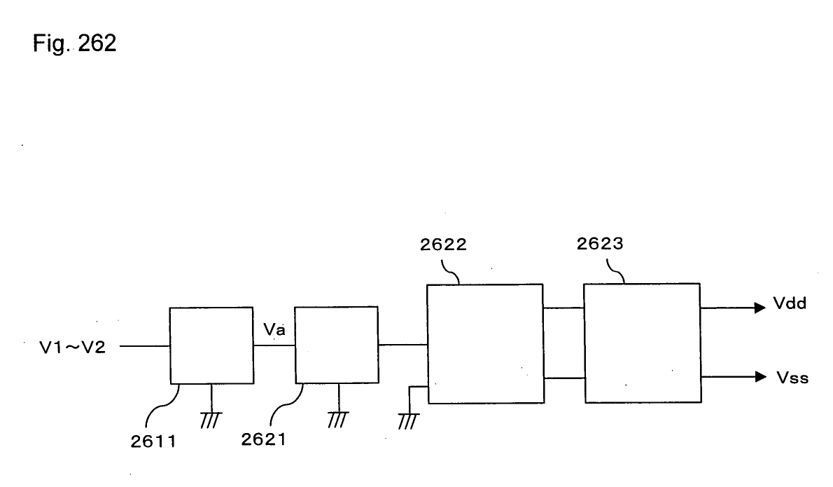

FIG. 262 shows the circuit for generating the Vdd and Vss voltages. The circuit for generating the Vdd and Vss voltages was also described in FIG. 119. FIG. 262 has the configuration using a transformer circuit. Voltages V1 to V2 from the battery are inputted to a regulator circuit 2611 having a charge pump circuit. The regulator circuit 2611 converts the inputted voltage to a constant voltage Va of 4 (V) in a charge pump circuit 2612a. The voltage Va (common with FIG. 261) is switched and rendered alternate by a switching circuit 2621. This AC signal is potential-converted by a circuit comprised of a transformer 2622, and a potential-converted voltage is converted to a DC voltage by a smoothing circuit 2623. The converted voltage becomes Vdd and Vss (potential shifts can be performed by the transformer).

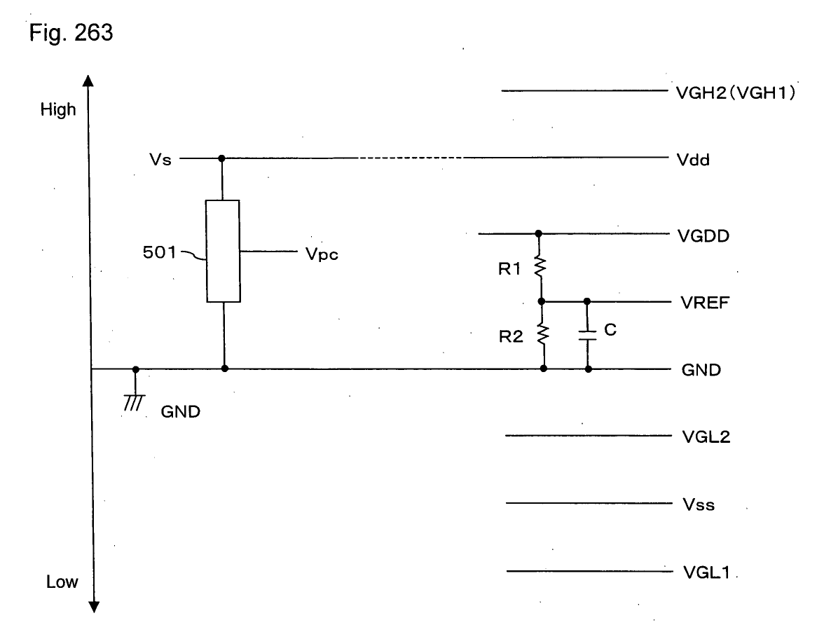

FIG. 263 shows the output voltage of the power supply circuit of the display panel of the present invention. A pre-charge voltage Vpc is generated in the electronic regulator 501 operating between the Vs voltage and the GND voltage. The VREF voltage is generated by the resistors (R1, R2) placed between the VGDD voltage and the GND voltage. A capacitor C is placed on the VREF voltage to stabilize it.

This voltage becomes the VGDD voltage. As a matter of course, it is also possible, as shown in FIG. 261, to generate 4 (V) which is +V and −4 (V) which is −V in the charge pump circuit (with no regulator function) 2612a for generating the positive voltage and negative voltage. The −4 (V) becomes the Vgl2 voltage. The charge pump circuit 2612a only generates the voltages in the positive and negative directions of Va, and so the configuration is very easy. Therefore, it is possible to realize reduction in the costs.

Hereunder, a description will be given by mainly referring to FIGS. 127 to 142 as to the EL display apparatus comprising the EL elements 15 placed like a matrix, the driving transistor 11a, and a drive circuit means of applying a signal to the driving transistor 11a and having a voltage gradation circuit 1271 for generating a program voltage signal, a current gradation circuit 164 for generating a program current signal, and switches 151a and 151b for switching between the program voltage signal and the program current signal.

A description will also be given by mainly referring to FIGS. 127 to 142 as to the driving method of the EL display apparatus having formed thereon EL elements 15 placed like a matrix and the driving transistor 11a and including the source signal line 18 for applying a signal to the driving transistor 11a, wherein one horizontal scanning period has a period A for applying a voltage signal to the source signal line 18 and a period B for applying a current signal to the source signal line 18, and the period B is started after an end of, or concurrently with the period A.

The pre-charge driving of the present invention applies a predetermined voltage to the source signal line 18. And the source driver IC outputs the program current. However, the present invention may also change the output voltage of the pre-charge driving according to the gradation. To be more specific, the pre-charge voltage outputted to the source signal line 18 is a program voltage. FIG. 127 shows the circuit configuration in which the voltage gradation circuit 1271 of the pre-charge voltage is installed in the source driver IC.

FIG. 127 is a block diagram of one output circuit corresponding to one source signal line 18. It is comprised of the current gradation circuit 164 for outputting the program current according to the gradation and the voltage gradation circuit 1271 for outputting the pre-charge voltage according to the gradation. The video data is applied to the current gradation circuit 164 and the voltage gradation circuit 1271. The output of the voltage gradation circuit 1271 is applied to the source signal line 18 by turning on the switches 151a and 151b. The switch 151a is controlled by a pre-charge enable (pre-charge ENBL) signal and a pre-charge signal (pre-charge SIG).

The voltage gradation circuit 1271 is comprised of a sample-hold circuit, a DA circuit and so on (refer to FIG. 308). Conversion to the pre-charge voltage is performed by the DA circuit based on digital video data. The converted pre-charge voltage is sample-held by the sample-hold circuit, and is applied to one terminal of the switch 151a via the operational amplifier. It is not necessary to configure or form the DA circuit for each voltage gradation circuit 1271. It is possible to configure the DA circuit outside the source driver circuit (IC) 14 and sample-hold the output of the DA circuit in the voltage gradation circuit 1271. It is also possible to form the DA circuit by a polysilicon technology.

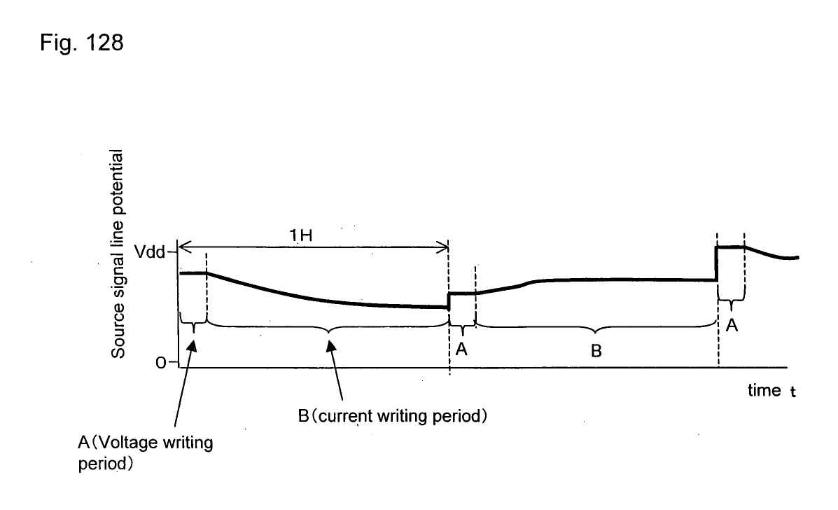

As shown in FIG. 128, the output of the voltage gradation circuit 1271 is applied to the beginning of 1H (indicated by a reference character A). Thereafter, the program current is supplied to the source signal line by the current gradation circuit 164 (indicated by a reference character B). To be more specific, the voltage is set by the pre-charge voltage up to a schematic source signal line potential. Therefore, the driving transistor 11a is set at high speed up to a value close to a target current. Thereafter, the target current (=program current) for compensating for characteristic variations of the driving transistor 11a is set by the program current outputted by the current gradation circuit 164.

The period A for applying the pre-charge voltage signal should preferably be a period of 1/100 to ⅕ of 1H. Or else, it should preferably be set as a period of 0.2 μsec. to 10 μsec. Therefore, except for the period A, it is the period for applying the program current of the period B. If the period A is short, the shortage of writing occurs because electric charge of the source signal line 18 is not sufficiently charged and discharged. If the period A is too long, a current application period (B) becomes too short to apply the program current sufficiently. Therefore, current correction of the driving transistor 11a becomes insufficient.

A voltage application period (A) should preferably be implemented from the beginning of 1H. However, it is not limited thereto. For instance, it may be started from a blanking period at the end of 1H. It is also possible to implement the period A halfway through 1H. To be more specific, the voltage application period should be implemented in one of the periods of 1H. However, the voltage application period should preferably be implemented within the period of ¼H (0.25H) from the beginning of 1H.

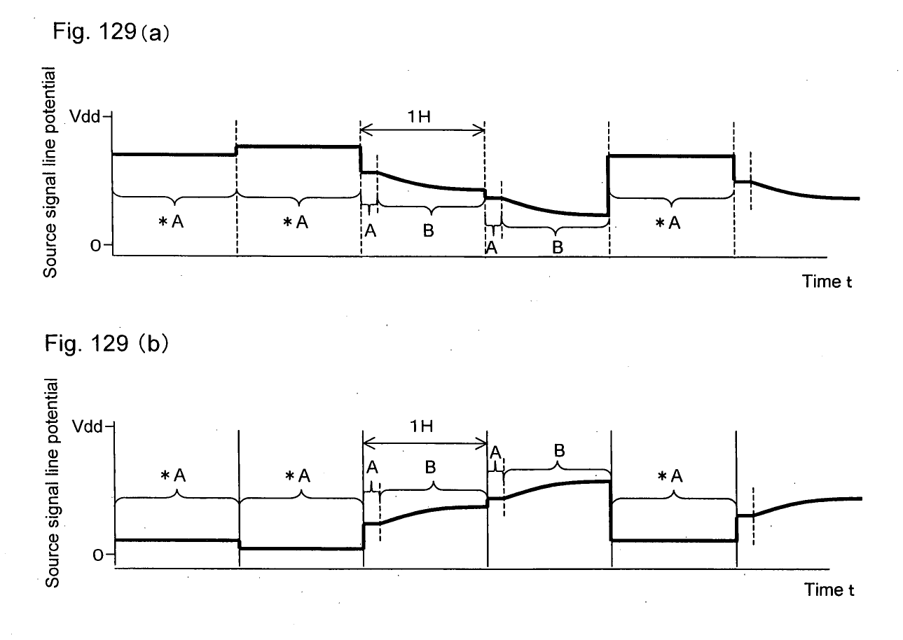

In the embodiment of FIG. 128, the current is applied (period B) after the period of voltage pre-charge (A). However, it is not limited thereto. For instance, all (or most of or a majority of) the periods of 1H may be the voltage pre-charge (*A) period as shown in FIG. 129(a).

As for the period *A of FIG. 129(a), the voltage program is implemented in the periods of 1H. The period *A is a low gradation region. If the current program is implemented in the low gradation region, the current to be programmed is minute. Therefore, a potential change to the source signal line 18 cannot be implemented due to influence of a parasitic capacitance of the source signal line 18. To be more specific, characteristic compensation of the. TFT 11a (driving transistor) cannot be performed. According to the current program method, a program current I and a luminance B are in a linear relation. For that reason, the change in luminance against one gradation is excessive in the low gradation region. Therefore, a gradation jump is apt to occur in the low gradation region.

As for this problem, the present invention implements the voltage program in the low gradation region for the period of 1H (indicated by *A) as shown in FIG. 129(a). A voltage step graduation of the voltage program is rendered smaller in the area of the low gradation region. If the voltage applied to the TFT 11a of the pixel 16 is rendered as a fixed step, the output current of the TFT 11a to the EL element 15 schematically becomes a square-law characteristic. Therefore, the luminance B against an applied voltage (the luminance B is in proportion to the output current to the EL element 15) becomes linear in terms of human visibility (because the human visibility recognizes that it is changing at a low step at the time of the square-law characteristic) According to the voltage program method, the characteristic compensation of the TFT 11a cannot be performed well. In the low gradation region, however, the display luminance of the display screen 144 is so low that unevenness in display due to shortage of the characteristic compensation is not visually recognized even if it occurs. On the other hand, the source signal line 18 can be charged and discharged well according to the voltage program method. For that reason, the source signal line 18 can be sufficiently charged and discharged even in the low gradation region so as to realize a proper gradation display.

As is understandable from FIG. 129(a), the voltage is applied to all (or most) of the periods of 1H in the case where the potential of the source signal line 18 is close to the anode potential (Vdd). If the potential of the source signal line 18 gets close to 0 (V), the voltage program (period A) and the current program (B) are implemented within the period of 1H. In the case where the potential of the source signal line 18 is close to 0 (V) (high gradation region), the current program may be implemented over all the periods of 1H.

As for the periods other than *A of FIG. 129(a), the voltage according to the voltage program is applied to the source signal line 18 in a fixed period of 1H (indicated by A), and thereafter, the current according to the current program is applied in the period of B. Thus, a predetermined voltage is applied to a gate potential of the TFT 11a of the pixel 16 by applying the voltage in the period A so as to set the current flowing to the EL element 15 approximately at a desired value. Thereafter, the current passing through the EL element 15 becomes a predetermined value because of the program current of the period B. As for the *A period, the voltage program is implemented (the voltage is applied) over all the periods of 1H.

FIG. 129(a) shows a signal waveform applied to the source signal line 18 in the case where the TFT (driving transistor) 11a of the pixel 16 is P-channel. However, the present invention is not limited thereto. The TFT 11a of the pixel 16 may also be N-channel (refer to FIG. 1 for instance). In this case, the voltage is applied to all (or most) of the periods of 1H if the potential of the source signal line 18 is close to 0 (V) as shown in FIG. 129(b). If the potential of the source signal line 18 gets close to the anode potential (Vdd), the voltage program (period A) and the current program (B) are implemented in the period of 1H.

In the case where the potential of the source signal line 18 is close to Vdd (high gradation region), the current program may be implemented over all of the periods of 1H.

According to the present invention, it is described that the driving transistor 11a is P-channel. However, it is not limited thereto. It goes without saying that the driving transistor 11a may also be N-channel. The description is given on condition that the driving transistor 11a is P-channel just to facilitate the description.

As for the embodiments of the present invention in FIGS. 128 and 129, the voltage program is main in the low gradation region and the writing is performed to the pixels. In the mid to high gradation region, the current program is main and the writing is performed. To be more specific, it is possible to realize integration of the advantages of both the current and voltage driving. It is because the low gradation region is displayed with predetermined gradations by the voltage. As a writing current is minute in the current driving, the voltage applied first in 1H (by the voltage driving or the pre-charge driving. The pre-charge driving and the voltage driving are conceptually the same. To differentiate them roughly, the pre-charge driving has a relatively few kinds of voltage to apply while the voltage driving has many kinds) becomes dominant.

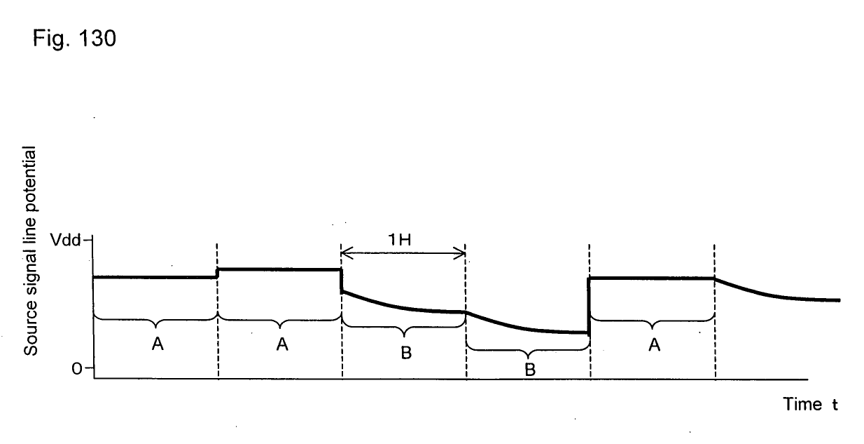

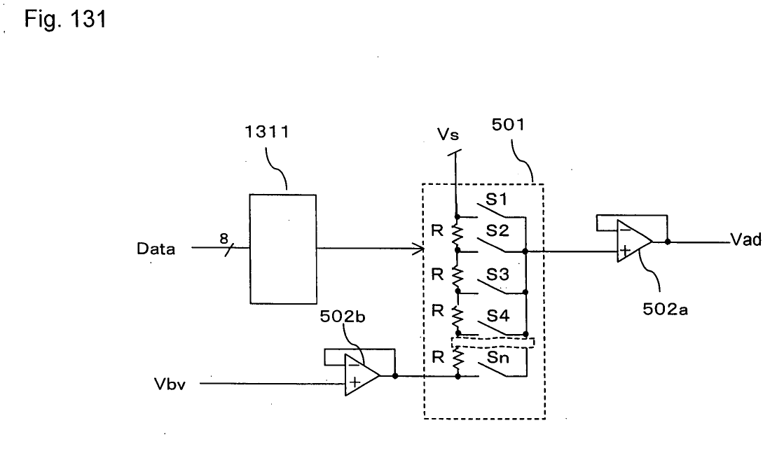

The mid gradation region compensates for an amount of deviation of the voltage with the program current after having it written by the voltage. To be more specific, the program current becomes dominant (the current driving is dominant). The high gradation region has it written by the program current. It is not necessary to apply the program voltage. It is because the applied voltage is rewritten by the program current. To be more specific, the current driving is overwhelmingly dominant (refer to FIGS. 130(b) and 131). It goes without saying that the voltage may also be applied.

In FIG. 127, it is possible to short the output of the voltage gradation circuit and the output of the current gradation circuit (including a pre-charge circuit) with the terminal 155 because the current gradation circuit has high impedance. To be more specific, the current gradation circuit has such high impedance that no problem (such as an overcurrent flowing due to a short circuit) arises to the circuit even if the voltage from the voltage gradation circuit is applied to the current gradation circuit.

Therefore, the present invention is not limited to switching a voltage output state and a current output state as described. It goes without saying that the switches 151 (refer to FIG. 127) may be turned on to apply the voltage of the voltage gradation circuit 1271 to the terminal 155 in the state of having the program current outputted from the current gradation circuit 164.

It is also feasible to output the program current from the current gradation circuit 164 in the state of closing the switches 151 and applying the voltage to the terminal 155. There is no problem circuit-wise because the current gradation circuit 164 has high impedance. The above state is also within the category of the operation of the present invention of switching between the voltage driving state and the current driving state. The present invention takes advantage of the properties of a current circuit and a voltage circuit. This is a characteristic configuration which no other driver circuit has.

It goes without saying, as shown in FIG. 130, that the program to be applied to the 1H period may be one of the voltage and current. In FIG. 130, the period of *A is the 1H period in which the voltage program is implemented and the period of B is the 1H period in which the current program is implemented. Primarily, the voltage program is implemented in the low gradation region (indicated by *A), and the current program is implemented in half-tone or higher gradation regions (indicated by B). It is possible, as described above, to switch whether to select the voltage driving or the current driving according to the gradation or the size of the program current.

As for the embodiment of the present invention in FIG. 127, the same video data is inputted to the voltage gradation circuit 1271 and the current gradation circuit 164. Therefore, a latching circuit of the video data may be in common with the voltage gradation circuit 1271 and the current gradation circuit 164. To be more specific, it is not necessary to provide the latching circuits of the video data independently to the voltage gradation circuit 1271 and the current gradation circuit 164. The current gradation circuit 164 and (or) the voltage gradation circuit 1271 output the data to the terminal 155 based on the data from the common video data latching circuit.

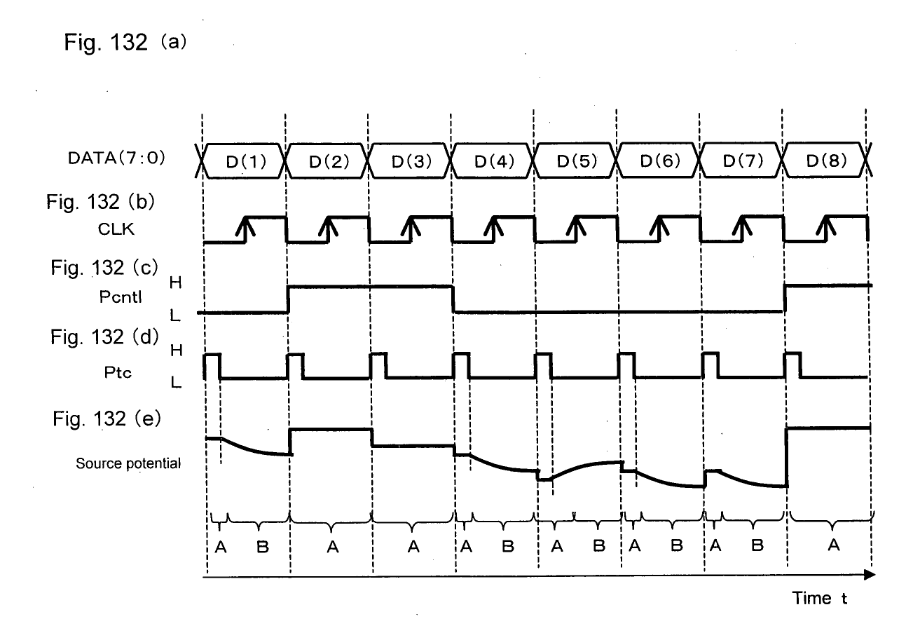

FIG. 132 is a timing chart of the driving method of the present invention. In FIG. 132, DATA of (a) is the image data. CLK of (b) is a circuit clock. Pcntl of (c) is a pre-charge control signal. When the Pcntl signal is at an H level, it is in a voltage driving only mode state. And when at an L level, it is in a voltage+current driving mode. Ptc of (d) is a switching signal of the output from the pre-charge voltage or the voltage gradation circuit 1271. When the Ptc signal is at the H level, the voltage output such as the pre-charge voltage is applied to the source signal line 18. When the Ptc signal is at the L level, the program current from the current gradation circuit 164 is outputted to the source signal line.

For instance, the Pcntl signal is at the H level in the case of data D(2), D(3) and D(8), and so the voltage is outputted from the voltage gradation circuit 1271 to the source signal line 18 (period A). When the Pcntl signal is at the L level, the voltage is outputted first to the source signal line 18 and then the program current is outputted thereto. Reference character A denotes the period for outputting the voltage, and B denotes the period for outputting the current. The period A for outputting the voltage is controlled by the Ptc signal. The Ptc signal is the signal for controlling on and off of the switches 151 in FIG. 127.

As already described, it is in the voltage driving only mode state when the Pcntl signal is at the H level, and it is in the voltage+current driving mode when at the L level. It is desirable to change the period for applying the voltage according to the lighting rate or the gradation. It is not possible, at a low gradation, to write the program current to the pixel completely by the current driving. Therefore, it is desirable to perform the voltage driving. It is possible, by extending the period for applying the voltage, to render the voltage driving mode dominant even in the voltage+current driving mode so as to finely write the low gradation state to the pixel. Many pixels are in the low. gradation state in the case of the low lighting rate. Therefore, even in the case of the low gradation state (low lighting rate), it is possible, by extending the period for applying the voltage, to render the voltage driving mode dominant even in the voltage+current driving mode so as to finely write the low gradation state to the pixel.

As described above, it is desirable, even in the voltage+current driving mode, to change the period of the voltage driving state according to the lighting rate or the gradation data (video data) to be written to the pixel. To be more specific, control is exerted, an adjustment is made or the apparatus is configured to extend a voltage driving mode period when reducing the current passing through the EL element 15 (the low lighting rate range of the present invention) and reduce or ‘eliminate’ the voltage driving mode period when increasing the current passing through the EL element 15 (the high lighting rate range of the present invention). The meaning of the lighting rate or the lighting rate state will be omitted since they are described in detail herein. It goes without saying that an application (operation) period, the duty ratio and the reference current ratio may be controlled or adjusted or the apparatus may be so configured as to the voltage driving mode in the voltage+current driving mode. It goes without saying that the above is applicable to the other embodiments of the present invention.

As for the embodiment having the voltage output and current output as in FIG. 127, it is not necessary that the number of output gradations of the voltage gradation circuit 1271 match with that of the current gradation circuit 164. For instance, there may be the case where the number of output gradations of the voltage gradation circuit 1271 is 128 gradations while that of the current gradation circuit 164 is 256 gradations. In this case, the gradations of the voltage gradation circuit 1271 correspond to a part of the gradations of the current gradation circuit 164. For instance, there is an embodiment shown, wherein 0-th gradation to 127-th gradation of the voltage gradation circuit 1271 correspond to the 0-th gradation to 127-th gradation of the current gradation circuit 164. In this embodiment, there is no output of the voltage gradation circuit 1271 to the 128-th to 255-th gradations of the current gradation circuit 164. There is an embodiment shown, wherein the gradations of the voltage gradation circuit 1271 correspond to odd-numbered gradations of the current gradation circuit 164.

It is described that FIG. 127 is a block diagram of one output terminal. This is intended to facilitate the description. For instance, it is easy to form one voltage gradation circuit 1271 and one current gradation circuit 164 in the source driver circuit (IC) 14 so as to output the output current or output voltage of these circuits by using the analog switch and selecting one output terminal 155 from multiple output terminals 155 or simultaneously selecting the multiple output terminals 155.

It goes without saying that, according to the present invention, an output period of the voltage signal outputted from the voltage gradation circuit 1271 may be changed correspondingly to the gradation. For instance, there is an embodiment shown, wherein the output period of the voltage signal outputted from the voltage gradation circuit 1271 is 1 μsec. from the 0-th gradation to 127-th gradation, and the output period of the voltage signal outputted from the voltage gradation circuit 1271 is 0.5 μsec. from the 128-th gradation to 255-th gradation. It goes without saying that the output period of the voltage signal outputted from the voltage gradation circuit 1271 may be changed proportionally or nonlinearly as to the 0-th gradation to 255-th gradation.

The above is also applicable to the current gradation circuit 164. For instance, there is an embodiment shown, wherein the output period of the current signal outputted from the current gradation circuit 164 is 50 μsec. from the 0-th gradation to 127-th gradation, and the output period of the current signal outputted from the current output circuit 164 is 20 μsec. from the 128-th gradation to 255-th gradation. It is of course that it goes without saying that the output period of the current signal outputted from the current gradation circuit 164 may be changed proportionally or nonlinearly as to the 0-th gradation to 255-th gradation.

The embodiment changes the output signal period of one of the current gradation circuit 164 and the voltage gradation circuit 1271 or the output signal periods of both of them correspondingly to the gradation. However, the present invention is not limited thereto. For instance, it goes without saying that the output signal period of one of the current gradation circuit 164 and the voltage gradation circuit 1271 may be changed or controlled correspondingly to the lighting rate, duty ratio, reference current ratio or size of the reference current, size of output voltage of the gate signal lines 17 and size of the anode voltage or cathode voltage.

According to the present invention, it goes without saying that the output signal period of one of the current gradation circuit 164 and the voltage gradation circuit 1271 may be fixed while changing the output signal period of the other circuit (164 or 1271).

It goes without saying that the above is applicable to the other embodiments of the present invention. In FIG. 132, the period A for outputting the voltage and the period B for outputting the current are switched. However, it is not limited thereto. It goes without saying that the switches 151 (refer to FIG. 127) may be turned on in the state of having the program current outputted so as to apply the voltage of the voltage gradation circuit 1271 to the terminal 155. It is also possible to output the program current from the current gradation circuit 164 in the state of closing the switches 151 and applying the voltage to the terminal 155. The switches 151 are opened after the period A. The current gradation circuit 164 has high impedance as described above, and so there is no problem circuit-wise if shorted with the voltage circuit.

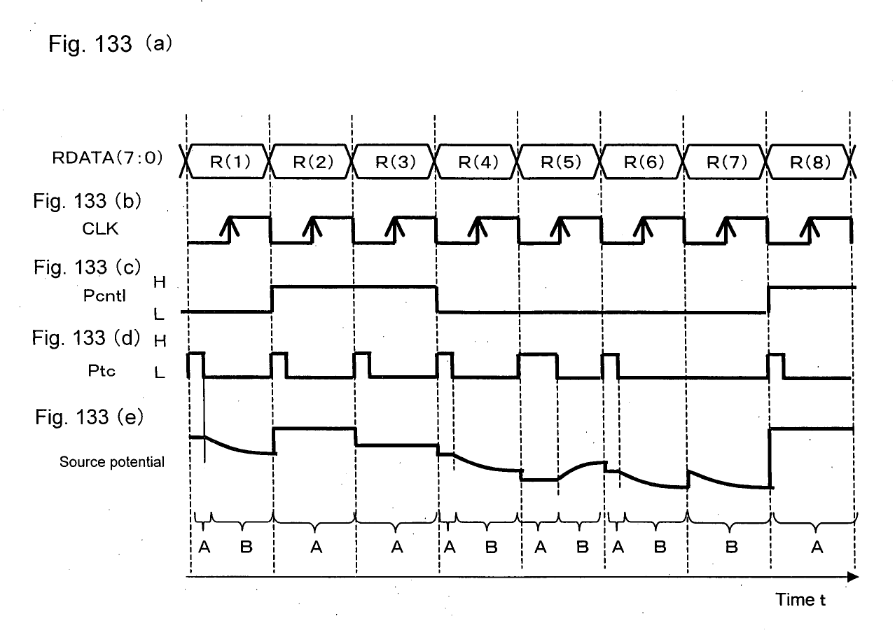

In FIG. 133, the H period of the Ptc signal is changed to render the period for outputting the voltage to the source signal line 18 variable. The H period is changed by a gradation number. For instance, the Ptc signal is at the L level for the period of 1H in D(7) Therefore, the switches 151 of FIG. 127 are in the open state for the period of 1H. Therefore, they have no voltage applied in the 1H period and are constantly in the current program state. The Ptc period is longer than the other 1H periods in D(5). Therefore, the period A for applying the voltage is set longer.

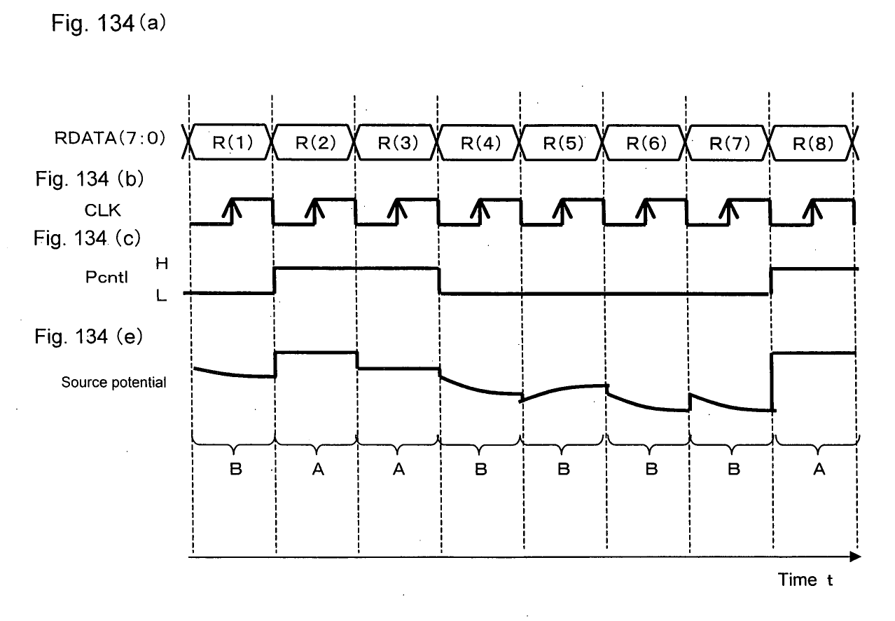

The embodiment switches between the current driving state and the voltage driving state. However, the present invention is not limited thereto. There is no Ptc signal in the embodiment in FIG. 134. Therefore, it is controlled by the Pcntl signal. For that reason, the voltage driving is performed in the H period and the current driving is performed in the L period.

The voltage program needs to change the voltage value outputted to the source signal line 18 according to the luminous efficiency of the EL element 15 of the RGB. It is because, exemplifying the pixel configuration in FIG. 1, the voltage (program voltage) applied to the gate terminal of the driving transistor 11a is different depending on the current outputted by the driving transistor 11a. The output current of the driving transistor 11a needs to be different according to the luminous efficiency of the EL element 15. To render the source driver circuit (IC) 14 of the present invention general-purpose, it is necessary to address the cases of a different pixel size of the EL display panel or a different luminous efficiency of the EL element 15 by means of a setup or an adjustment.

The voltage gradation circuit 1271 outputs the voltage with the anode voltage (Vdd) as its origin. FIG. 135 shows this state. The anode voltage (Vdd) is an operational origin of the driving transistor 11a. To facilitate the description, a description will be given on condition that the driving transistor 11a as shown in FIG. 1 is P-channel. A description will be omitted as to the case where the driving transistor 11a is N-channel because only the origin position is different. Therefore, a description will be given by exemplifying the case where the driving transistor 11a is P-channel to facilitate the description.

In FIG. 135, the horizontal axis is the gradation. A description will be given on condition that the output gradations of the voltage gradation circuit 1271 are 256 (8-bit) gradations in the present invention. The vertical axis is the output voltage to the source signal line 18. In FIG. 135, the potential of the source signal line 18 lowers in proportion to the gradation number.

The voltage of the source signal line 18 is the gate terminal voltage of the driving transistor 11a. The output current of the driving transistor 11a changes nonlinearly to the gate terminal voltage. In general, if the voltage is applied to the source signal line 18 as in FIG. 135, the output current of the driving transistor 11a changes against the applied voltage with the square-law characteristic. To be more specific, the potential of the source signal line 18 is in proportion to the gradation in FIG. 135. However, the output current of the driving transistor 11a (current passing through the EL element 15) approximately becomes the square-law characteristic.

The circuit configuration in FIG. 135 is simple. However, the current passing through the EL element 15 is not in proportion to the gradation number. It is because, if a linearly changing voltage is applied to the driving transistor 11a (such as the case of the embodiment in FIG. 135), the output current is outputted in proportion to a square of the applied voltage due to the square-law characteristic of the driving transistor 11a. Therefore, the change in the output current of the driving transistor 11a is small when the gradation number is small, and drastically becomes larger as the gradation number becomes larger. Therefore, accuracy of the output current against the gradation number changes.

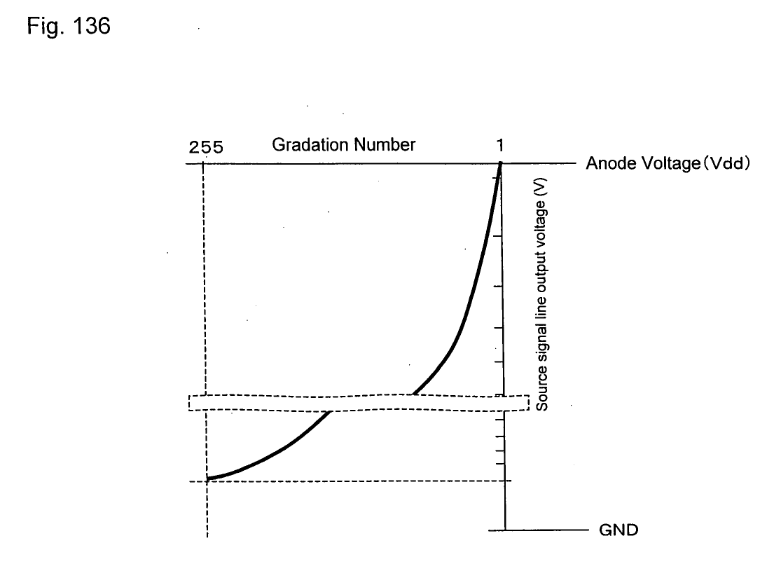

FIG. 136 shows the configuration for solving this problem. In FIG. 136, the change in the output voltage to the source signal line 18 is large when the gradation number is small. The smaller the gradation number becomes, the larger a voltage change ratio to the source signal line 18 becomes. If the gradation number becomes larger (closer to the 256^{th}), the change in the output voltage to the source signal line 18 becomes smaller. Therefore, the relation of the source signal line output current against the gradation number is nonlinear. This nonlinear characteristic is rendered linear by combining it with an output current characteristic of the driving transistor 11a to the EL element 15 against the gate terminal voltage. To be more specific, the output current to the EL element 15 of the driving transistor 11a against the change in the gradation number is adjusted to be linear.

According to the current program method, the current passing through the EL element 15 is in a linear relation to the gradation number. The configuration (method) of FIG. 136 is the voltage program method. While the voltage program method is used for FIG. 136, the current passing through the EL element 15 is in the linear relation to the gradation number. Therefore, they are matching well in the configuration (method) combining the current program method with the voltage program method such as FIGS. 127 and 128.

In FIG. 136, an output current Ie of the driving transistor 11a changes almost linearly against the gradation number. Therefore, the relation of the source signal line output voltage to the gradation number changes roughly when the gradation number is small, and changes minutely as it becomes large. When the gradation number is K and the source signal line is Vs, a change curve formula should be as follows, which is shown in FIG. 136. Source signal line voltage Vs=A/(K·K). A is a constant of proportion. Otherwise, it should be as follows. Source signal line voltage Vs=A/(B·K·K+C·K+D) or Vs=A/(B·K˜K+C). D, B, C and A are constants.

As described above, it is possible, by configuring the change curve formula, to put the output current of the driving transistor Ie in the linear relation to the source signal line voltage Vs when multiplying Ie against Vs by the change curve formula.

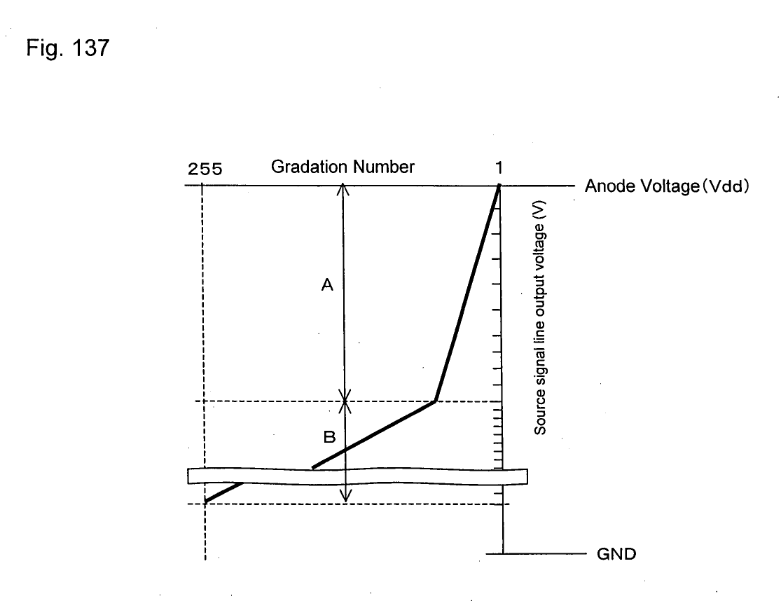

In FIG. 136, the change curve formula becomes a curve. Therefore, it is relatively difficult to create the change curve. As for this problem, it is adequate to configure the change curve formula with multiple straight lines as shown in FIG. 137. To be more specific, the change curve should be composed of two or more inclined straight lines.

In FIG. 136, a graduation of the output voltage of the source signal line 18 is rendered larger in the range of small gradation numbers (indicated by A). The graduation of the output voltage of the source signal line 18 is rendered smaller in the range of large gradation numbers (indicated by B). As for the change curve of FIG. 136, the output current Ie of the driving transistor 11a is in a nonlinear relation to the gradation number K, where multiple nonlinear outputs are combined. However, the relation of the output current Ie to the gradation number K is mostly in an almost linear range. Therefore, combination with the current program driving is also easy.

In FIG. 136, the voltage gradation circuit 1271 and the current gradation circuit 164 are formed in one source driver circuit (IC) 14. However, it is not limited thereto. The present invention is characterized by having the voltage gradation circuit 1271 and the current gradation circuit 164. Therefore, it is also possible to place, form or mount the voltage gradation circuit (IC) 1271 on one end of one source signal line 18 and place, form or mount the current gradation circuit (IC) 164 on the other end of the source signal line. To be more specific, the present invention may have any configuration based on the configuration or method capable of implementing the current program and voltage program to an arbitrary pixel.

The driver circuit (IC) 14 for implementing the voltage program has a gamma characteristic of reverse 1.5^{th} to 3.0^{th} power. To be more specific, it is possible to realize a current increase at regular intervals correspondingly to change steps of the gate voltage of the driving transistor 11a. It is because a V-I characteristic of the driving transistor 11a is approximately the square-law characteristic (because the output current I changes approximately with the square-law characteristic against a voltage V change) Furthermore, it is desirable to render the gamma characteristic of the driver circuit (IC) for implementing the voltage program as the gamma characteristic of reverse 1.8^{th} to 2.4^{th} power.

It is desirable to configure the gamma characteristic of the driver circuit (IC) for implementing the voltage program as programmable. In the case where the driving transistor 11a is the P-channel transistor, the origin of a gamma characteristic curve is at the anode voltage Vdd or in proximity to Vdd. In the case where the driving transistor 11a is the N-channel transistor, the origin of the gamma characteristic curve is at the cathode voltage Vss or the ground of the circuit 14 or the potential in proximity thereto.

It goes without saying that the above is also applicable to FIGS. 127 to 143, 293, 311, 312, and 339 to 344. To be more specific, as to the pre-charge circuit, it goes without saying that the pre-charge circuit (IC) may be formed or placed on one end of one source signal line 18 and the source driver circuit (IC) 14 of the current program method may be formed or placed on the other end of the source signal line 18. It goes without saying that the above is also applicable to the other embodiments of the present invention.

The change in the voltage gradation circuit 1271 (pre-charge circuit) and the change in the current gradation circuit 164 are synchronized. To be more specific, the voltage gradation circuit 1271 (pre-charge circuit) is changed so that the change therein corresponds to the change in the current gradation circuit 164. If the target value (expected value) of the output current of the driving transistor 11a of the pixel 16 according to the voltage gradation circuit 1271 is 1 μA, the gradation is controlled so that the target value (expected value) of the driving transistor 11a of the pixel 16 according to the current gradation circuit 164 becomes 1 μA. Therefore, it is desirable to have a configuration in which the value of the gradation data on the current gradation circuit 164 matches with the gradation data on the voltage gradation circuit 1271 (pre-charge circuit). It goes without saying that the above is also applicable to the other embodiments of the present invention. It is also desirable to synchronize them.

The present invention is not limited to implementing both the voltage program (pre-charge) and current program on the entire source signal lines 18. It is also possible to implement just one of them. For instance, it is feasible to implement the voltage program (pre-charge) on odd-numbered pixel rows and implement the current program on even-numbered pixel rows. There is almost no reduction in image quality even in such a configuration. It goes without saying that the above is also applicable to the other embodiments of the present invention.

In the embodiment in FIG. 135, the potential of the source signal line 18 is not the anode potential (Vdd) when the gradation number is 0. As for the driving transistor 11a, the output current is 0 or almost 0 up to a threshold voltage. The range up to the threshold voltage is a region of C. Therefore, as the region of C becomes blank, it is possible to render the graduation of the output voltage of the source signal line relatively minute compared to FIG. 135 in the case where the gradation number is fixed.

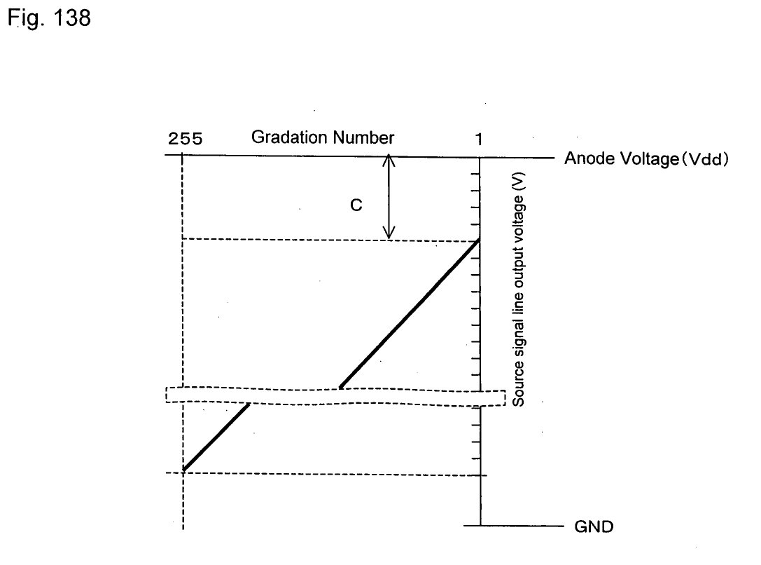

It goes without saying that it is possible to mutually combine the relation of FIG. 138 (relation in which the potential of the source signal line 18 is not the origin (anode potential) when the gradation number is 0), the nonlinear relation of FIG. 136, the relation of FIG. 137 combining multiple relational expressions and the linear relation of FIG. 135.

As for the voltage program, it is necessary to change the voltage value outputted to the source signal line 18 according to the luminous efficiencies of the EL elements 15 of the R, G and B. It is because, exemplifying the pixel configuration in FIG. 1, the voltage (program voltage) applied to the gate terminal of the driving transistor 11a is different depending on the current outputted by the driving transistor 11a. The output current of the driving transistor 11a needs to be different according to the luminous efficiency of the EL element 15. To render the source driver circuit (IC) 14 of the present invention general-purpose, it is necessary to address the cases of a different pixel size of the EL display panel or a different luminous efficiency of the EL element 15 by means of the setup or adjustment.

FIG. 131 is the circuit configuration utilizing the point that the reference of the voltage in the voltage driving is Vdd. The voltage size Vdd as the vertical axis of FIGS. 135 to 138 is fixed and changed. Therefore, it is possible, even if the range of the gradation numbers (256 gradations=256 graduations) is fixed, to adjust the voltage size as the vertical axis so as to render the source driver circuit (IC) 14 general-purpose.

In FIG. 131, the voltage range of the electronic regulator 501 is Vdd to Vbv. Therefore, an output voltage Vad of an operational amplifier 502a has the values Vdd to Vbv outputted. Vbv is inputted from outside the source driver circuit (IC) 14. It may also be generated inside the source driver circuit (IC) 14. A switch S of the electronic regulator 501 has 8-bit control data (gradation number) decoded by a decoder circuit 532, and the switch S is closed to have the voltage of Vdd to Vbv outputted from Vad. The voltage Vad becomes the voltage as the vertical axis of FIGS. 135 to 138.

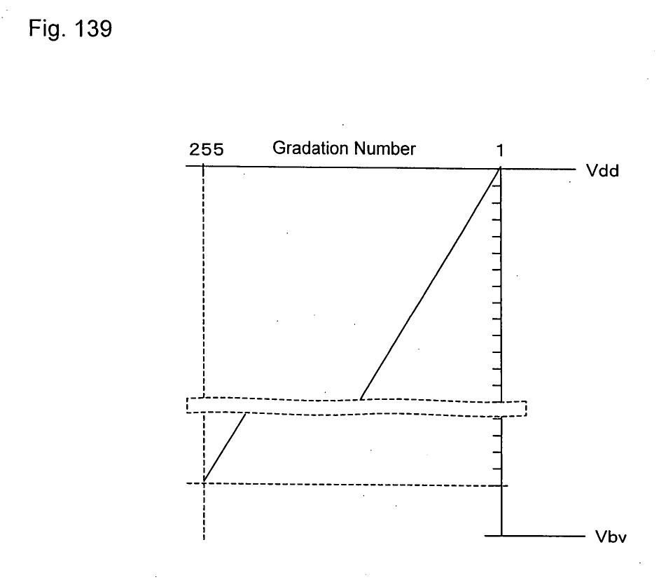

Therefore, it is possible to change or adjust Vad easily by changing Vbv. To be more specific, the vertical axis is in the range of the voltages Vdd to Vbv as shown in FIG. 139. The above circuit configuration of FIG. 131 is provided to each of the RGB as shown in FIG. 140. It goes without saying that, in the case where the luminous efficiencies of the EL elements 15 of the RGB are balanced and a white balance can be struck when an RGB current Ic is Icr:Icg:Icb=1:1:1, the RGB may have one circuit configuration in common (FIG. 131). It is also possible to render multiple Ic current generation circuits in common, such as R and G, G and B and B and R. It goes without saying that Vbv can be changed according to the lighting rate, reference current ratio and duty ratio.

FIGS. 77 and 78 have a two-stage latching circuit 771 for a current program circuit. The source driver circuit (IC) 14 of the present invention comprises both the current program circuit and voltage program circuit.

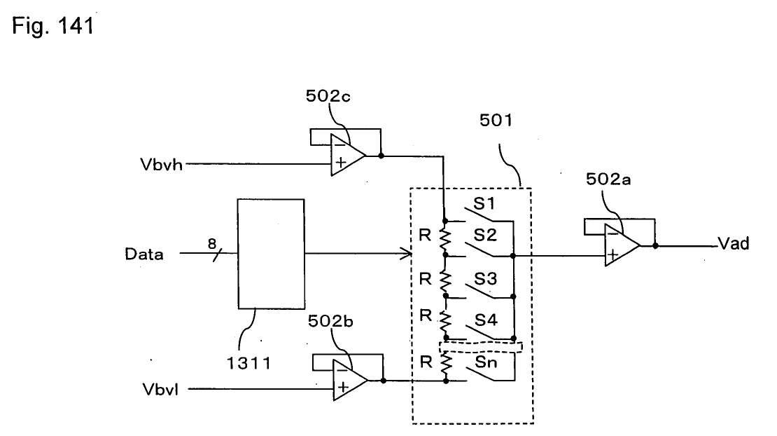

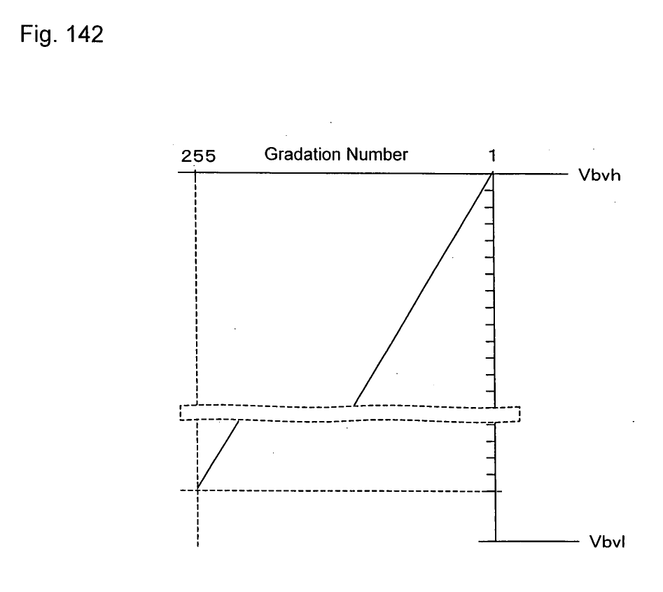

FIG. 131 has the anode voltage Vdd as the origin. FIG. 141 allows the voltage falling under the anode potential to be adjusted. The voltage from an operational amplifier 502c is applied to a terminal Vdd of the electronic regulator 501. The applied voltage is Vbvh. A lower limit voltage of the electronic regulator 501 is Vbvl. Therefore, the voltage range applied to the source signal line 18 is Vbvh to Vbvl as shown in FIG. 142. Other points are the same as or similar to the other embodiments, and so a description thereof will be omitted.

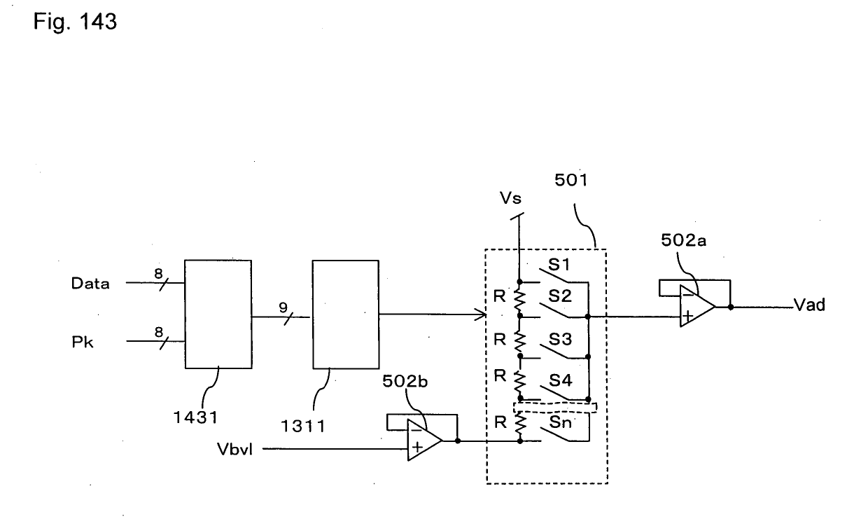

As described in FIG. 138, the driving transistor 11a has the threshold voltage shown in C. The threshold voltage and thereunder is a black display (the driving transistor 11a supplies no current to the EL element 15). FIG. 143 shows the circuit for generating the blank C of FIG. 138. The voltage range of the blank C is adjusted with Pk data. The Pk data is 8 bits. The Pk data is added to gradation number data by an adder 3731. The added data becomes 9 bits, is inputted to the decoder circuit 532 and decoded so as to close the switch S of the electronic regulator 501.

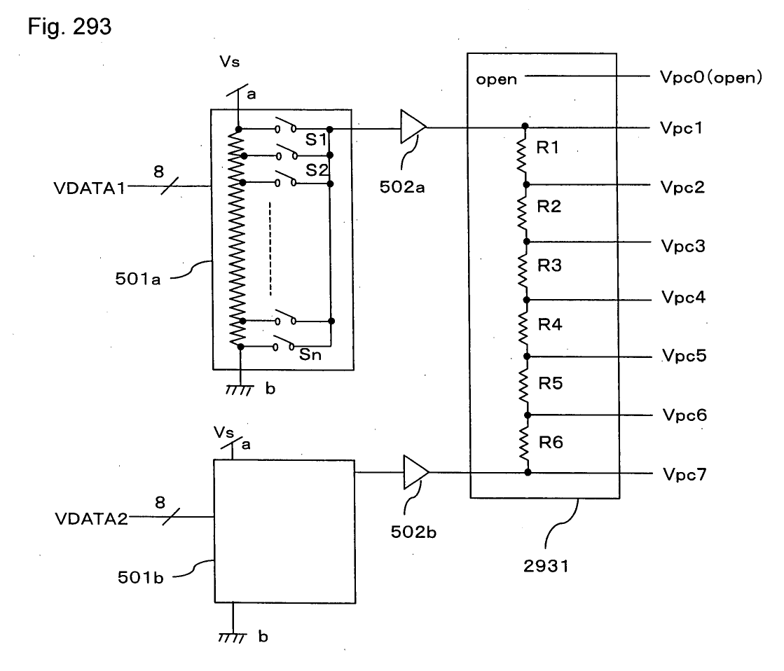

FIG. 293 shows another embodiment of the circuit for generating the pre-charge voltage (synonymous with or similar to the program voltage). The resistors consist of diffused resistors or polysilicon resistors. In the case where the resistance values vary, the trimming is performed in order to obtain a predetermined resistance value. As the trimming was described in FIGS. 162 to 173, a description thereof will be omitted.

According to the embodiment, the number of built-in resistors of a resistance array 2931 is 6 pieces of R1 to R6. However, it is not limited thereto. It may be over or below 6 pieces. However, the number of the pre-charge voltage (synonymous with or similar to the program voltage) Vpc generated by the resistors should preferably be multiplier of 2−1 or multiplier of 2−2. As shown in FIG. 293, this −1 is intended to specify the open state (the mode for applying no pre-charge voltage (synonymous with or similar to the program voltage)).

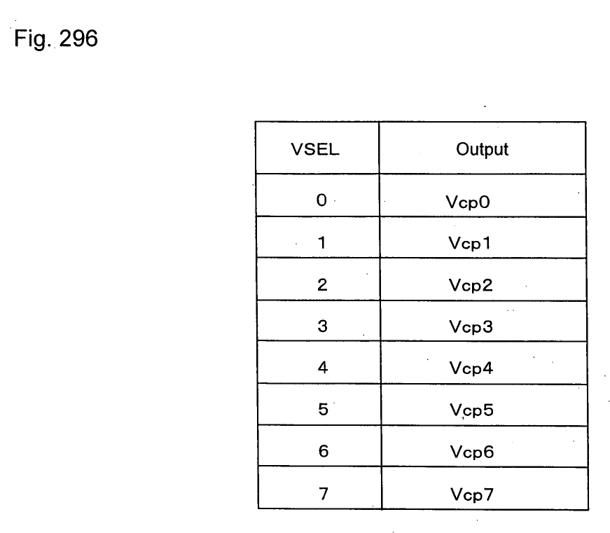

For instance, when VSEL data for specifying the pre-charge voltage (synonymous with or similar to the program voltage) is 0 in FIG. 296, it is Vpc0 (open: applying no pre-charge voltage (synonymous with or similar to the program voltage). As Vpc0 is specified, it is possible to implement the drive only for the period of B of FIG. 128 (no period for not applying the voltage shown in A). To be more specific, the pixel 16 (the source signal line 18) has no pre-charge voltage (synonymous with or similar to the program voltage) (synonymous with the program voltage) applied thereto (no voltage program is implemented), and only the current program is implemented. of multiplier of 2−2, −1 is Vpc0 (open mode) previously described. Another mode is the one for taking in the pre-charge voltage (synonymous with or similar to the program voltage) generated outside the source driver circuit (IC) 14 from the terminal thereof and using it.

The pre-charge voltage (synonymous with or similar to the program voltage) of external input is not limited to being fixed. It goes without saying that it may change in synchronization with a dot clock of the circuit of the panel (correspondingly to each pixel 16). This is also applicable to the internal pre-charge voltage (synonymous with or similar to the program voltage). For instance, it goes without saying that a pre-charge voltage (synonymous with or similar to the program voltage) Vpc1 may change in synchronization with a dot clock of the circuit of the panel (correspondingly to each pixel 16).

For instance, if VSEL is 4 bits, 8 numbers are specifiable. Therefore, in the case of the configuration of multiplier of 2−1, 7 pre-charge voltages (synonymous with or similar to the program voltages) are specifiable, where the remaining one is the open mode. And in the case of the configuration of multiplier of 2−2, 6 pre-charge voltages (synonymous with or similar to the program voltages) are specifiable, where the remaining one is the open mode and the pre-charge voltage (synonymous with or similar to the program voltage) of the external input is specifiable as the other one. If the VSEL for specifying the pre-charge voltage (driving the voltage program) is 8 bits, 256 numbers are specifiable.

Therefore, in the case of the configuration of multiplier of 2−1, 255 pre-charge voltages (synonymous with or similar to the program voltages) are specifiable, where the remaining one is the open mode. And in the case of the configuration of multiplier of 2−2, 254 pre-charge voltages (synonymous with or similar to the program voltages) are specifiable, where the remaining one is the open mode and the pre-charge voltage (synonymous with or similar to the program voltage) of the external input is specifiable as the other one.

According to the embodiment, −1 is the open mode in the case of the configuration of multiplier of 2−1. However, it is not limited thereto. −1 may also be the mode for specifying the pre-charge voltage (synonymous with or similar to the program voltage) of the external input. The pre-charge voltage (synonymous with or similar to the program voltage) of external input is not limited to one kind. It may also be multiple kinds. In that case, the pre-charge voltage (synonymous with or similar to the program voltage) internally generated decreases. It is not limited to specifying different pre-charge voltages (synonymous with or similar to the program voltages) Vpc to all the specifications other than −1 or −2.

It goes without saying that it may be configured, formed or made to have the same pre-charge voltage (synonymous with or similar to the program voltage) outputted in multiple pieces of specified data. It goes without saying that it may be configured, formed or made to have the pre-charge voltage (synonymous with or similar to the program voltage) in the open mode or external input mode outputted in multiple pieces of specified data. It goes without saying that the above embodiment is applicable to the embodiments in FIGS. 127 to 143. It goes without saying that it is also applicable to the other embodiments hereof.

The embodiment may also have the configuration of multiplier of 2−3. One is the open mode, and the other one may be the pre-charge voltage (synonymous with or similar to the program voltage) of the external input as a specified mode and the remaining one mode may be the anode voltage. A good black display can be implemented by applying the anode voltage Vdd.

In FIG. 293, it is possible, by extending an application period (1H period at the maximum) of the pre-charge voltage (synonymous with or similar to the program voltage), to implement the voltage program as shown in FIGS. 129 and 130 (the state in which only voltage data is applied to the source signal line 18 or the pixel 16 while applying no current data). To be more specific, it is possible, by controlling a selection period or selection timing of the VSEL (refer to FIG. 296), to select one of the voltage program method and the current program method or combine both the program methods based on predetermined ratios and periods.

It is also easy to change the ratio for combining both the program methods according to the size of the video data (gradation data) applied to the pixel 16. It is also easy to change the ratio for combining both the program methods according to the size or a change state of the video data (gradation data) continuous in the pixel 16 direction. It is also possible to implement only one of the program methods. When combining both the program methods, the voltage program method is implemented first.

It is also possible to change the pre-charge period (voltage application period of the voltage gradation circuit 1271) according to the size of the gradation data. The pre-charge period (voltage application period of the voltage gradation circuit 1271) is extended at the low gradation, and is reduced as it becomes half-tone.

As described above, the present invention is characterized in that the pre-charge voltage (synonymous with or similar to the program voltage) can be set with the digital signal, and at least one of the specifications can select the mode for inputting the pre-charge voltage (synonymous with or similar to the program voltage) from outside or applying no pre-charge voltage (synonymous with or similar to the program voltage).

The change in the pre-charge circuit (comprised of the electronic regulator 501 and so on, or the voltage gradation circuit 1271 of FIG. 136) and the change in the current gradation circuit 431c are synchronized. To be more specific, the change in the pre-charge circuit should be made correspondingly to the change in the current gradation circuit 431c. If the target value (expected value) of the output current of the driving transistor 11a of the pixel 16 according to the pre-charge circuit is 1 μA, the gradation is controlled so that the target value (expected value) of the driving transistor 11a of the pixel 16 according to the pre-charge circuit becomes 1 μA.

Therefore, it is desirable to have a configuration in which the value of the gradation data on the pre-charge circuit matches with the gradation data on the current gradation circuit 431c. It goes without saying that the above is applicable to the other embodiments of the present invention. It is also desirable to synchronize the pre-charge circuit and the current gradation circuit 431c.

A determination on whether or not to apply the program current may be made based on the image data of an immediately preceding pixel line (or the image data applied to the source signal line immediately before). For instance, in the case where a 63^{rd} gradation is the largest white display and a 0^{th} gradation is a complete black display in 64 gradations, and when the image data applied to a certain source signal line 18 is 63^{rd} gradation→10^{th} gradation→10^{th} gradation, the program voltage is applied on turning to the 10^{th} gradation from the 63^{rd} gradation. It is because it is difficult to write at the low gradation.

As for a basic operation, the program voltage is applied and then the program current is applied thereafter so as to correct the current. When changing from the same gradation to the same gradation (from the 10^{th} gradation to the 10^{th} gradation for instance) or from a certain gradation to a gradation in proximity thereto (from the 10^{th} gradation to the 9^{th} gradation for instance), only the program current is applied without applying the program voltage. It is because, if the program voltage is applied, laser shot unevenness occurs due to characteristic variations of the driving transistor 11a. It is because, in the case of the driving only with the program current, the gradation change is so little that even a minute current can follow the characteristic variations of the driving transistor 11a.

It goes without saying that, as to the driving method or the display panel of the present invention, a long side direction of an anneal (ELA) shot with an excimer laser should desirably form or configure an array 30 in accordance with a forming direction of the source signal line 18 (rendering a scan direction of the laser orthogonal to the forming direction of the source signal line 18). It is because, as to the characteristic change in the driving transistor 11a of the pixel 16, the characteristics are matching in one shot of the laser anneal (ELA) (to be more specific, the characteristics of the driving transistor 11a (mobility (μ), value S and so on) are matching in the pixel row in the forming direction of the source signal line 18).

The embodiment of the present invention describes that the program voltage is applied. However, the program voltage may be replaced by the pre-charge voltage. It is because, in the case where the pre-charge voltage has multiple kinds of voltage, the operation is the same as that in the case of the program voltage.

When the image (video) data applied to a next pixel line (pixel) is the same as, or has a smaller amount of change than the image (video) data applied to the preceding pixel line (pixel), only the program current is applied without applying the program voltage. It is because the program current applied to the preceding pixel line has the potential of the program current to be written next by the potential of the source signal line 18 (an amount of displacement is only the characteristic variation of the driving transistor 11a) Therefore, the program voltage is not applied in the case of the raster display (though it may be applied). The above operation can be easily implemented by forming (placing) a line memory equivalent to one pixel line (2 lines of memory are required for FIFO) on the controller circuit (IC) 760. As for the first pixel line, however, it is desirable to apply the program voltage because there is a problem of a vertical blanking period.

The present invention describes that the program voltage is applied in the case of program voltage+program current driving. However, it is not limited thereto. It may also be a method of writing the current shorter than one horizontal scanning period and larger than the program current to the source signal line 18. To be more specific, it may also be the method of writing the pre-charge current to the source signal line 18 and then writing the program current to the source signal line 18 thereafter. The pre-charge current is not different in that it is physically causing the voltage change.

As described above, the method of performing the operation of the program voltage application with the pre-charge current or the pre-charge voltage is within the category of the program voltage+program current driving of the present invention. For instance, the program voltage is changed by switching the electronic regulator 501 in FIGS. 131, 140, 141, 143, 293, 297, 311, 312 and 339 to 344. The electronic regulator 501 should be changed to the electronic regulator of the current output. The change can be easily implemented by combining multiple current mirror circuits. To facilitate the description, the present invention describes that the program voltage application in the program voltage+program current driving is performed by the voltage.

The program voltage application is not limited to applying a certain program voltage. For instance, it is possible to apply multiple program voltages to the source signal line. For instance, it is the method of applying a first program voltage 5 (V) for 5 (μsec.) and then applying a second program voltage 4.5 (V) for 5 (μsec.) thereafter. Thereafter, the program current Iw is applied to the source signal line 18. It may also be the program voltage changed to a sawtooth waveform. It is also possible to apply the voltages in a rectangular waveform, a chopping waveform and a sine curve form. It is also possible to superimpose the program voltage (current) on a normal program current (voltage). The size of the program voltage (current) and the application period of the program voltage (current) may be changed correspondingly to the image data. The kind of applied waveform and the value of the program voltage may be changed according to the value of the image data.

It is also possible to apply the program voltage from one end of an upper hem of the source signal line 18 and apply the program current from one end of a lower hem of the source signal line 18. It is also possible to thus place or configure the driver circuit 14 of the display panel.

It is possible to apply the program current and the program voltage simultaneously. It is because a constant current (variable current) circuit for generating the program current is a high-impedance circuit and so there is no problem in the operation when shorted with the voltage circuit for generating the program voltage. In the case of applying both the program voltage and program current to the source signal line 18, however, the application of the program current is finished after finishing the application of the program voltage. To be more specific, 1H (horizontal scanning period) or multiple Hs or a predetermined period should be finished lastly in the state of applying the program current. It goes without saying that overcurrent driving (pre-charge current driving) shown in FIG. 390 may be combined therewith.

The present invention describes that the program current is applied after applying the program voltage of the predetermined voltage in the current driving method. However, the technical idea of the present invention is also effective in the voltage driving method. In the case of the voltage driving method, the size of the driving transistor for driving the EL element 15 is large and so a gate capacity is large. For that reason, there is a problem that it is difficult to write a normal program voltage.

As for this problem, it is possible to apply the voltage of the predetermined voltage before applying the normal program voltage and thereby reset the driving transistor so as to implement good writing (the applied voltage should preferably be the voltage for putting the driving transistor 11a in the off state or in proximity thereto). Therefore, the program voltage+program current driving method of the present invention is not limited to the current program driving. The embodiment of the present invention will be described by exemplifying the pixel configuration of the current program driving (refer to FIG. 1) to facilitate the description. According to the embodiment of the present invention, the program voltage+program current driving method (also refer to FIGS. 127 to 143) does not work only on the driving transistor 11a. For instance, it works on the driving transistor 11a configuring the current mirror circuit in the pixel configuration of FIGS. 11, 12 and 13, and is effective. One of the objects of the program voltage+program current driving method of the present invention is to charge and discharge the parasitic capacitance of the source signal line 18 viewed from the source driver circuit (IC) 14. As a matter of course, it is also the object to charge and discharge the parasitic capacitance in the source driver circuit (IC) 14.

One of the objects of the operation of applying the program voltage is to perform the black display well. However, it is not limited thereto. It is also possible to implement good white display by applying a white writing program voltage (current) for facilitating writing of the white display. To be more specific, the program voltage+program current driving of the present invention applies the predetermined voltage (according to the gradation data to be written to the pixel 16) for facilitating the writing of the program current (program voltage) and preliminarily charges the source signal line 18 before writing the program current (program voltage). It also applies the program voltage in advance in order to facilitate the writing of the program current according to the gradation. Therefore, it is not necessary to apply the program voltage if the potential of the source signal line 18 is kept at a predetermined potential or in a predetermined range.

However, the driving transistor 11a of the pixel 16 changes from a white display state (high-gradation display state) to a black display state (low-gradation display state) at relatively high speed. Nevertheless, the driving transistor 11a changes from the black display state to the white display state at relatively low speed. Therefore, it is desirable to apply the program voltage by rendering it larger than the value of the video (image) data (high-gradation display direction) and operate it to be corrected in a black display direction by the program current. Therefore, it is desirable to satisfy the relation of the video data specifying the program voltage >the video data specifying the program current.

It is the case where the driving transistor 11a of the pixel 16 is the P-channel transistor and the current program is implemented by a sink current (current absorbed in the source driver circuit (IC) 14). In the case where the driving transistor 11a of the pixel 16 is the N-channel transistor or the current program is implemented by a discharge current (current discharged from the source driver circuit (IC) 14) of the driving transistor 11a, the relation is inverse. To be more specific, in the case where the driving transistor 11a of the pixel 16 is N-channel, it changes from the black display state (low-gradation display state) to the white display state (high-gradation display state) at relatively high speed.

However, the driving transistor 11a changes from the white display state to the black display state at relatively low speed. Therefore, it is desirable to apply the program voltage by rendering it smaller than the value of the video (image) data (low-gradation display direction) and operate it to be corrected in a white display direction by the program current. Therefore, it is desirable to satisfy the relation of the video data specifying the program voltage<the video data specifying the program current. It goes without saying that the above is applicable to (replaceable by) the other embodiments of the present invention.

To facilitate the description, the present invention will be described by exemplifying the display panel (display apparatus) of which driving transistor (transistor for supplying electric power to the EL element 15) is P-channel and source driver circuit (IC) 14 is operated by the sink current.

As for program voltage application timing, it is desirable to write the program voltage in a state in which the pixel line for writing the program current is selected. However, it is not limited thereto. It is also possible to preliminarily charge the source signal line 18 by applying the program voltage thereto in a state in which the pixel line is unselected and then select the pixel line for writing the program current thereafter.

The program voltage should be applied to the source signal line 18. However, other methods are also exemplified. For instance, it is possible to change (add the program voltage to) the voltage applied to the anode terminal (Vdd) or the voltage applied to the cathode terminal (Vss). Writing capability of the driving transistor 11a is expanded by changing the anode voltage or the cathode voltage. Therefore, a program voltage discharge effect is exerted. In particular, it is highly effective to implement the method of changing the anode voltage pulse-wise. To be more specific, it goes without saying that the program voltage may be applied to any signal line or terminal (anode terminal, cathode terminal and source signal line) as long as it is the operation or configuration for putting the driving transistor 11a in the off state.

FIG. 332(a) is a schematic diagram on applying the program voltage only at gradation 0. It is a desirable method to apply the program voltage only at gradation 0 because there is no gradation jump and the good black display can be implemented. In FIGS. 332, a line number indicates the number of the pixel line. As for the pixel lines, the image data is sequentially rewritten from a first pixel line to an n-th pixel line. If the current program is performed up to the last pixel line n, the current program is started again from the first pixel line.

The image data is the image data of 64 gradations by way of example. The image data takes a value of 0 to 63. It takes a value of 0 to 255 in the case of 256 gradations as a matter of course. PSL is a program voltage application selection number, where the output of the program voltage is allowed at the H level (reference character H). The program voltage is not outputted at the L level. PEN is a program voltage application enable signal. The PEN is the signal to be outputted by determination of a controller 81. To be more specific, the controller sets a PEN signal at the H or L level based on the image data. When the PEN is at the H level, it is a determination signal for applying the program voltage. When the PEN is at the L level, it is a determination signal for not applying the program voltage. It goes without saying that the program voltage should desirably be changed according to the image data. A concrete configuration method will be described in FIGS. 127 to 143 and FIGS. 293 to 297.

In FIGS. 332, the PEN signal is at the H level only at the gradation 0. An output P is the on and off state of the switch 151a (refer to FIGS. 16, 75 and Si of FIG. 308). In the table, a symbol ∘ denotes the on state of the switch 151a (the state in which the program voltage Vp is applied to the source signal line 18). And a symbol×denotes the off state of the switch 151a (the state in which no program voltage is applied to the source signal line 18).

In FIG. 332(a), the PEN signal is at the H level at a location falling under the pixel line numbers 3 and 8. At the same time, a PSL signal is also at the H level at the pixel line numbers 3 and 8, and so a P output is o (the state in which the program voltage Vp is outputted) In FIG. 332(b), the PEN signal is the same as that in FIG. 332(a). However, the PSL signal is at the L level. Therefore, the output P is constantly in the state of×(the state in which no program voltage Vp is outputted). Basically, the PEN signal is also outputted from the controller 81. It is desirable, however, to render the PEN signal adjustable by the user.

The period for which the program voltage Vp is outputted can be set up by a counter 162 of FIG. 16. This counter is a programmable counter which operates based on a set value from the controller or a set value of the user. A counter 651 operates in synchronization with a main clock (CLK).

FIG. 333(a) is a schematic diagram on applying the program voltage only at gradation 0 to gradation 7. The method of applying the program voltage only to the low gradation region is effective as a measure for solving the problem that it is difficult for the current driving to write to the black display area. It is possible to set the extent to which the program voltage is applied with the controller 81.

In FIGS. 333, the PEN signal is at the H level only at gradation 0 to gradation 7. The output P is the on and off state of the switch 151a. In FIG. 333(a), the image data is 7 or less and so the PEN signal is H at the locations falling under the pixel line numbers 3, 5, 6, 7, 11, 12 and 13. At the same time, the PSL signal is also at the H level at the locations, and so the output P is ∘ (the state in which the program voltage Vp is outputted). In FIG. 333(b), the PSL signal is at the L level, and so the output P is entirely×(the state in which no program voltage is outputted).

FIG. 334 is a schematic diagram of the driving method of performing the program voltage application when the luminance of the pixel 16 becomes low. In the case of the current program method, the program current Iw is large when increasing the luminance of the pixel 16 (white display). Therefore, even if there is the parasitic capacitance in the source signal line 18, it is possible to charge and discharge the parasitic capacitance sufficiently. When applying the program voltage to render the pixel 16 as the black display, however, the program current is small and so the parasitic capacitance in the source signal line 18 cannot be charged and discharged sufficiently. Therefore, there are many cases where it is not necessary to apply the program voltage when the program current to be written to the pixel 16 becomes large. Inversely, it becomes necessary to apply the program voltage when the program current to be written to the pixel 16 becomes small (when it becomes the black display).

FIG. 334 is a schematic diagram of the driving method of performing the program voltage application when the luminance of the pixel 16 becomes low. The image data on the 1^{st} pixel line is 39. Therefore, the potential for current-programming the pixel 16 in the image data 39 is held in the source signal line 18. The image data on the 2^{nd} pixel line is 12. Therefore, the source signal line 18 needs to be at the potential corresponding to image data 12. However, the program current becomes smaller from gradation 39 to gradation 12. For that reason, there may arise a state incapable of charging and discharging the source signal line 18 sufficiently. To cope with this problem, the program voltage application is performed (the PEN signal becomes the H level). The determination result is the same as to the pixel lines 3, 5, 6, 8, 11, 12, 13 and 15.

The image data on the 3rd pixel line is 0. Therefore, the potential for current-programming the pixel 16 in the image data 0 is held in the source signal line 18. The image data on the 4th pixel line is 21. Therefore, the source signal line 18 needs to be at the potential corresponding to image data 21. The program current becomes larger from gradation 0 to gradation 21. For that reason, it is possible to perform charging and discharging the source signal line 18 sufficiently. Therefore, it is not necessary to apply the program voltage on the 4^{th} pixel line.

The above determination is made by the controller 81. As a result thereof, the PEN signal is at the H level on the pixel lines 2, 3, 5, 6, 8, 11, 12, 13 and 15 as shown in FIG. 334(a). To be more specific, the program voltage is applied on the pixel lines consequently. In FIG. 334(a), the PSL signal is also at the H level, and so the output P is ∘ (the program voltage is outputted) on the pixel lines 2, 3, 5, 6, 8, 11, 12, 13 and 15 as indicated in the output P column. The program voltage is not applied on the other pixel lines.

In FIG. 334(b), the PEN signal is the same as that in FIG. 334(a). However, the PSL signal is at the L level. Therefore, the output P is constantly in the state of×(the state in which no program voltage Vp is outputted). Basically, the PEN signal is also outputted from the controller 81. It is desirable, however, to render the PEN signal adjustable by the user.

FIG. 335 shows the method combining the program voltage application methods of FIGS. 333 and 334. It is the method of performing the program voltage application when the luminance of the pixel 16 becomes low and also performing the program voltage application when the program current of the pixel 16 is at low luminance of gradations 0 to 7. It is changeable by the set value of the controller 81 as to which gradation and thereunder the program voltage application should be performed. It is also changeable by the user. The change is made to a table inside the controller from the microcomputer via a serial interface.

The image data is the same as the embodiment in FIG. 334. In FIGS. 335, however, the image data is 12 on the 2^{nd} pixel line and 12 on the 15^{th} pixel line so that the PEN signal is at the L level as the determination result. As previously described, if the program current Iw is a certain size or larger, the parasitic capacitance in the source signal line 18 can be charged and discharged. Therefore, it is not necessary to apply the program voltage. Inversely, if the program voltage is applied, the potential of the source signal line 18 changes up to a black display potential and it takes time to return to the potential of a half-tone display.

The above determination is made by the controller 81. As a result thereof, the PEN signal is at the H level on the pixel lines 3, 5, 6, 8, 11, 12 and 13 as shown in FIG. 335(a). To be more specific, the program voltage is applied on the pixel lines consequently. In FIG. 335(a), the PSL signal is also at the H level, and so the output P is ∘(the program voltage is outputted) on the pixel lines 3, 5, 6, 8, 11, 12 and 13 as indicated in the output P column. The program voltage is not applied on the other pixel lines. In FIG. 335 (b), the PEN signal is the same as that in FIG. 335 (a). However, the PSL signal is at the L level. Therefore, the output P is constantly in the state of×(the state in which no program voltage Vp is outputted).

The embodiment does not describe the program voltage application of each of the RGB. However, it goes without saying that the determination of the program voltage application should preferably be made as to each of the RGB as in FIG. 336. It is because the image data is different as to each of the RGB.

FIG. 336 shows the driving method of performing the program voltage application in the range of gradations 0 to 7 as with FIG. 333. The determination of the program voltage application as to each of the RGB is made by the controller 81. As a result thereof, the PEN signal is at the H level on the pixel lines 3, 5, 6, 7, 8, 11, 12 and 13 as to R image data as shown in FIG. 336. To be more specific, the program voltage is applied on the pixel lines consequently. The PEN signal is at the H level on the pixel lines 3, 7, 9, 11, 12, 13 and 14 as to G image data. To be more specific, the program voltage is applied on the pixel lines consequently. The PEN signal is at the H level on the pixel lines 1, 2, 3, 6, 7, 8, 9 and 15 as to B image data. To be more specific, the program voltage is applied on the pixel lines consequently.

The embodiment determined whether or not to apply the program voltage correspondingly to the pixel lines. However, the present invention is not limited to this. It goes without saying that it is feasible to determine the size and change of the image data applied to each pixel by the frame (field) so as to judge whether or not to apply the program voltage. FIG. 337 is an embodiment thereof.

FIG. 337 shows the change in the image data by focusing attention on a certain pixel 16. The first line of the table in FIG. 337 indicates a frame number. The second line of the table indicates the change in the image data programmed in the pixel 16. FIG. 337 is a deformation example of the driving method of applying the program voltage at gradation 0 as with FIG. 332. FIG. 332 shows the method of applying the program voltage at gradation 0 without fail. FIG. 337 shows the method of applying the program voltage when the gradation 0 continues over certain frames. Continuation is indicated by the counter.

In FIG. 337(a), the gradation is 0 in the frames 3, 4, 5, 6, 11 and 12. For that reason, count values are counted sequentially from the 3^{rd} frame to the 6^{th} frame. They are also counted in the frames 11 and 12. In FIG. (a), control is exerted to apply the program voltage when the gradation 0 continues over three frames. Therefore, the output P becomes ∘ (the program voltage is outputted) in the frames 5 and 6. As gradation 0 only continues over two frames in the frames 11 and 12, the program voltage is not applied.

In FIG. 337(b), count control is performed by the PSL signal. The count value is counted up when the PSL signal is at the H level. In FIG. 337(b), it is not counted up because the PSL signal is at the L level in the frames 5 and 12. For that reason, the program voltage is outputted only in the frame 6.

In FIGS. 337, it was described that the program voltage is applied when the gradation 0 continues over certain frames. However, the present invention is not limited thereto. It is also possible, as described in FIGS. 333, to exert control to apply the program voltage when a certain gradation range (gradations 0 to 7 for instance) continues. It is not limited to the continuous frames but may also be discrete. It is also possible to exert control to apply the program voltage when a certain gradation range (only gradation 0 or gradations 0 to 7 for instance) continues on continuous pixel lines.

As described above, the program voltage+program current driving method of the present invention determines whether or not to apply the program voltage based on the value of the image data, the state of the change in the image data or the value of the image data in proximity to the pixel to which the program voltage is applied and the change therein so as to apply the program voltage (current). Information on whether or not to apply the program voltage is held by the source driver circuit (IC). Therefore, the source driver circuit (IC) 14 only comprises a latching circuit 2361 (holding circuit or storage means (memory)) for latching a program voltage application signal, and so the configuration thereof is simple. It is also general-purpose because it can support any program voltage application method by changing the program of the controller circuit (IC) 760 (refer to FIGS. 83, 85, 181, 319, 320 and 327) or changing the set value thereof.

The above described the case of the method of rendering the pixel as the black display or putting it in the state close to the black display by the program voltage application. However, there are also the cases of rendering the pixel as the white display by applying the program voltage. Therefore, the program voltage application does not only mean a black display voltage. It is the method of rendering it as a constant potential to the source signal line 18 by applying the voltage to the source signal line 18.

In the case where the driving transistor 11a of the pixel 16 is P-channel as in FIG. 1, it is important to form the switching transistor 11b as P-channel. It is because the black display is rendered easier by a punch-through voltage on turning the switching transistor 11b from the on state to the off state. Accordingly, in the case where the driving transistor 11a of the pixel 16 is N-channel, it is important to form the switching transistor 11b as N-channel. It is because the black display is rendered easier by a punch-through voltage on turning the switching transistor 11b from the on state to the off state.

The lower part shows a source signal line potential on applying the program voltage (PRV) to the source signal line 18. The location of the arrow indicates the position of the program voltage (PRV) application. The position of the program voltage application is not limited to the beginning of 1H. The program voltage may be applied in the period up to ½H. When applying the program voltage to the source signal line 18, it is desirable to operate an OEV terminal of a gate driver 12a on the selection side so as to have none of the gate signal lines 17a selected.

The determination of whether or not to apply the program voltage may be made based on the image data of the immediately preceding pixel line (or the image data applied to the source signal line immediately before). As for the image data applied to a certain source signal line 18, in the case where the applied data of the pixel line (pixel) immediately preceding the 1^{st} pixel line (last pixel line) is the 63^{rd} gradation and the 1^{st} pixel line is the 10^{th} gradation while there is no change in the image data thereafter (the 10^{th} gradation continues), the program voltage of the 10^{th} gradation or in proximity thereto is applied to the 1^{st} pixel line (pixel). However, no program voltage is applied to the 2^{nd} pixel line to the last pixel line.

FIG. 338 shows the relation between program current data (IR for red, IG for green and IB for blue) and program voltage data (VR for red, VG for green and VB for blue). The program current data and program voltage data are generated by the controller circuit (IC) 760 based on the video (image) data (refer to FIGS. 127 to 143).

FIG. 338(a) shows an example having the same number of the program current data (IR for red, IG for green and IB for blue) and program voltage data (VR for red, VG for green and VB for blue). To be more specific, it is the case of having the program voltage data (VR for red, VG for green and VB for blue) corresponding to arbitrary program current data (IR for red, IG for green and IB for blue). Therefore, it is possible, when the program voltage is applied, to apply the program current corresponding thereto.

FIG. 338(b) shows an embodiment having less program voltage data (VR for red, VG for green and VB for blue) than the program current data (IR for red, IG for green and IB for blue). The program voltage data (VR for red, VG for green and VB for blue) does not have low order 2 bits. In general, the gradation display may be rough at the low gradation. In the embodiment of FIG. 338(b), for instance, before applying the program current data of gradations 0 to 3, the program voltage data of gradation 0 is applied. Before applying the program current data of gradations 4 to 7, the program voltage data of gradation 1 (gradation 4 in reality without 2 low order bits) is applied.

FIG. 338(c) shows an embodiment having less program voltage data (VR for red, VG for green and VB for blue) than the program current data (IR for red, IG for green and IB for blue). The program voltage data (VR for red, VG for green and VB for blue) does not have high order and low order 2 bits. In general, the gradation display may be rough at the low gradation. In the embodiment of FIG. 338(c), for instance, before applying the program current data of gradations 0 to 3, the program voltage data of gradation 0 is applied. Before applying the program current data of gradations 4 to 7, the program voltage data of gradation 1 (gradation 4 in reality without 2 low order bits) is applied. In the high gradation region, the program current is predominant and so there is no need to apply the program voltage. Therefore, when applying the program voltage in the high gradation region, the maximum value of the program voltage data (VR for red, VG for green and VB for blue) is applied to the source signal line 18 and so on.

In FIG. 293, a potential c of the resistance array 2931 is decided by the output of an electronic regulator 501a. A potential d of the resistance array 2931 is decided by the output of an electronic regulator 501b. The resistance array 2931 is formed with the resistance values at the ratio of 1, 3, 5, 7 . . . (2n−1). If added from a point c, it is 1, 4, 9, 16, 25 . . . (n·n). To be more specific, it is the square-law characteristic. Therefore, the pre-charge voltage (synonymous with or similar to the program voltage) Vpc has a potential difference between the point c and a point d by an approximately square-law characteristic graduation.

It is not limited to the square graduation but may be in the range of 1.5^{th} to 3^{rd} power. This range should desirably be configured to be changeable. As for the change, a resistor R*(* is the number of the resistor) of the resistance array 2931 should be formed by multiple resistance values to be switched according to the object. It is changed in the range of 1.5^{th} to 3^{rd} power because a good image display can be implemented by changing the gamma characteristic according to the image. It is also because the pre-charge voltage (synonymous with or similar to the program voltage) needs to change along with the change in the gamma. The above was described in FIGS. 106, 108(a) and (b), and so a description thereof will be omitted.

It is possible, by having the configuration as in FIG. 293, to change the origin of the pre-charge voltage (synonymous with or similar to the program voltage) (point c=Vcp1) and the last point of the pre-charge voltage (synonymous with or similar to the program voltage) (point d=Vcp7). It is also possible to output the voltages of Vcp1 and Vcp7 by the square graduation so as to output an optimum pre-charge voltage (synonymous with or similar to the program voltage) according to the gradation (refer to the descriptions in FIGS. 135 to 142). It goes without saying that, in the case where an output method of the gradation is linear, the resistors of the resistance array 2931 may also be at regular resistance intervals. In the case of combining it with the current program method in particular, the pre-charge driving (voltage program method) in FIG. 293 should preferably be at regular intervals.

Vpc0 of FIG. 293 is open. To be more specific, no voltage is applied when Vpc0 is selected. Therefore, no pre-charge voltage (synonymous with or similar to the program voltage) is applied to the source signal line 18.

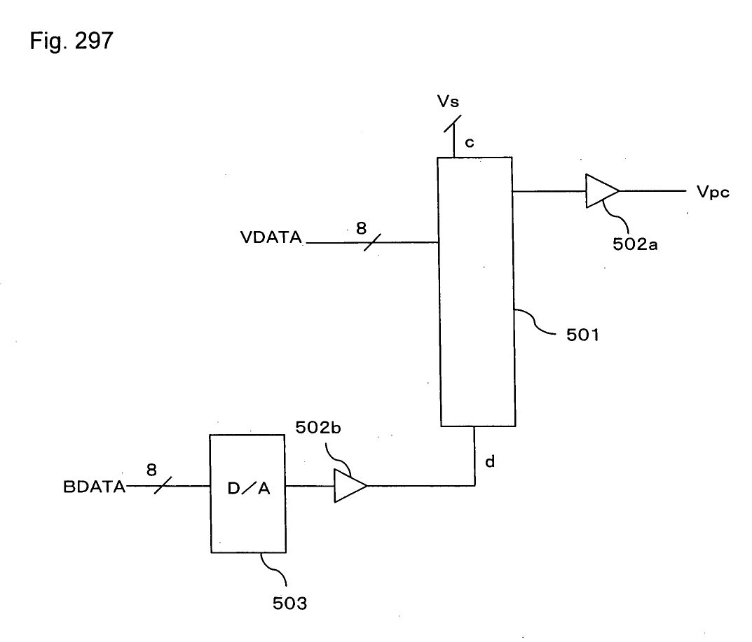

FIG. 293 has the configuration for changing both the voltages of the points c and d. It is also possible, however, to change only the point d as shown in FIG. 297. The pre-charge voltage (synonymous with or similar to the program voltage) is not limited to eight pieces as shown in FIG. 293 but may be any number if multiple. FIG. 297 has the configuration using a DA circuit 503. However, a voltage d may be changed in an analog fashion by using a voltage regulator (VR) as shown in FIG. 311.

The voltage Vs as the origin of the pre-charge voltage (synonymous with or similar to the program voltage) in FIG. 297 may be the voltage generated outside the source driver circuit (IC) 14. In FIG. 324, a voltage V0 is generated in the voltage regulator (VR) and applied to the electronic regulator 501 as the voltage common to the source driver circuit (IC) 14. To be more specific, the voltage V0 is used as the voltage Vs in FIGS. 131, 143, 308, 311 and 312. The voltage Vs can be the same as the anode voltage Vdd so as to decrease the number of the power supplies.

The embodiment described that the pre-charge voltage (synonymous with or similar to the program voltage) is the voltage close to the anode voltage. Depending on the pixel configuration, however, there are the cases where the pre-charge voltage (synonymous with or similar to the program voltage) is close to the cathode voltage. For instance, in the case where the driving transistor 11a consists of the N-channel transistor, there are the cases where the driving transistor 11a has the current program implemented by the discharge current (the pixel configuration of FIG. 1 is the sink current) on the P-channel transistor.

In this case, it is necessary to render the pre-charge voltage (synonymous with or similar to the program voltage) as the voltage close to the cathode voltage. For instance, it is necessary to render the point d as the reference position in FIG. 297. In FIG. 293, it is necessary to render the output voltage of an operational amplifier 502b as the reference. It is necessary to render the voltage Vbv of FIG. 131 as the reference and render Vbvl as the reference in FIGS. 141 and 143. It goes without saying that, if the pixel configuration changes as above, the reference position needs to be changed.

It is also possible, as shown in FIG. 312, to configure it by using a voltage selector circuit 2951. The pre-charge voltage (synonymous with or similar to the program voltage) Vpc changed by the electronic regulator 501 is applied to a terminal a of the voltage selector circuit, and a fixed pre-charge voltage (synonymous with or similar to the program voltage) Vc is applied to a terminal b.

FIG. 339 is another embodiment of the present invention. As for the pre-charge voltage (program voltage) V0 falling under the 0^{th} gradation of the electronic regulator, the fixed voltage is applied to the RGB as shown in FIG. 324. As a matter of course, it may be varied according to each of the RGB. In general, it may be common to the RGB in the case of a CCM method. The resistor R may be mounted outside the electronic regulator 501 as shown. The resistor R may be changed or replaced so as to change each voltage Vpc freely.

It is configured to maintain the relation of the resistance values R1>R2>. . .>Rn. And at least the relation of R1>Rn is maintained (Rn is the resistor for deciding the voltage Vpc outputted from the last switch, and R1 is on the low gradation side while Rn is on the high gradation side. R1 is for voltage generation in proximity to the threshold voltage of the driving transistor 11a, and Rn generates a white display voltage). In particular, it is desirable to maintain the relation of R1>R2 (inter-terminal voltage of R1>inter-terminal voltage of R2). It is because, due to the characteristic of the driving transistor 11a, the difference from the 1^{st} gradation following the voltage V0 and the difference between the voltage of the 1^{st} gradation and the voltage of the 2^{nd} gradation are large.

The switch S is specified by decoding VDATA. It is preferable that the number of selectable voltages Vpc be ⅛ or more of the number of gradations of the display apparatus in the case where the display apparatus is 6 inches or more (32 gradations or more in the case of 256 gradations). Especially, ¼ or more of that is preferable (64 gradations or more in the case of 256 gradations). It is because the shortage of writing of the program current occurs up to a relatively high gradation region. It is preferable that the number of selectable voltages Vpc be 2 or more in the case of a relatively small display panel (display apparatus) of below 6 inches. It is because, although a good black display can be implemented even if Vpc is one voltage V0, there are the cases where it is difficult to perform the gradation display in the low gradation region. If there are two or more voltages Vpc, multiple gradations can be generated by FRC control so as to implement a good image display.

SDATA for deciding the potential of the point b is relative to the reference current Ic. Preferably, it should be controlled to be proportional to 1/1.5^{th} to ⅓^{rd} power of Ic. When the reference current Ic is large, control is exerted to lower the potential of the point b. And when the reference current Ic is small, the potential of the point b becomes higher. Therefore, when the reference current Ic is large, the potential differences among the resistors R become larger and the differences among the voltages Vpc become larger (step variation of the program voltage becomes larger). Inversely, when the reference current Ic is small, the potential differences among the resistors R become smaller and the differences among the voltages Vpc become smaller. For instance, the potential of the point b is changed by the reference current Ic as shown in FIG. 344, and is changed in proportion to the potential differences among resistance terminals of the electronic regulator 501 by the potential differences from the voltage V0.

In FIG. 344, the potential of the terminal b is changed directly by the reference current Ic. However, it is not limited thereto. It is also possible to use the current having converted the reference currents Ic (Icr, Icg and Icb) of FIG. 188 with a current shunt circuit or a translate circuit. It is configured so that the current obtained by conversion becomes ½^{nd} power or in proximity thereto of the reference current. It goes without saying that the reference currents Ic of the electronic regulator 501 of the RGB should preferably be variable as to each of the RGB.

For instance, FIG. 343 has a configuration in which the reference current Ic (or the current proportional or relative to the reference current) is let into the current mirror circuit comprised of transistors 158b and 158c so as to apply the voltage V1 generated on one end of a resistor R0 to the terminal b via the operational amplifier 502a. It is possible, by thus configuring it, to change the pre-charge voltage (program voltage) according to or relatively to the change in the reference current (the lighting rate control of the present invention changes the reference current to control the display luminance or power consumption). The voltage change in the terminal b should be modestly performed, or else, the flicker occurs to the image. As a countermeasure against this, the embodiment in FIG. 343 has the capacitor C placed or formed on the terminal b.

According to the embodiments of the present invention, there are the cases where the operational amplifier 502 is used as an analog process circuit such as an amplifier circuit, and there are the cases where it is used as a buffer.

As described above, the voltage change (change in the pre-charge voltage (program voltage) Vpc) in the terminal b in the change in the reference current (change due to the lighting rate control) is modestly performed. It goes without saying that the above is applicable likewise to the other embodiments of the present invention (refer to FIGS. 343 and 339).

The embodiment in FIG. 345 is shown as an example of the configuration for changing or modifying the pre-charge voltage (program voltage) according to or relatively to the change in the reference current Ic. In the embodiment in FIG. 345, the current mirror circuit (consisting of the transistors 158b, 158c and so on) for the reference current Ic (or the current in proportion to or relative to the reference current Ic) is configured. The resistor R0 is mounted (placed or formed) on the outside of the source driver circuit (IC) 14. It is possible, by replacing or changing the resistor R0, to change or vary the voltages of the terminals b of the electronic regulators 501a and 501b.

The resistor R0 is not limited to the fixed resistor and regulator. It may also be a nonlinear element, such as a zener diode, a transistor or a thyristor. It may also be a circuit or an element, such as a constant-voltage regulator or a switching power supply. It may also be an element such as a posistor or a thermistor instead of the resistor R0. It is thereby possible to perform temperature compensation simultaneously with potential adjustment of the terminals b. It is also possible to replace the resistor of the source driver circuit (IC) 14 likewise.

It goes without saying that the above is applicable likewise to the other embodiments of the present invention. For instance, there are exemplifications such as the resistor R1 of FIGS. 188 and 209, resistors R1 to R3 of FIGS. 197 and 346, VR of FIG. 311, VR of FIG. 324, R1 to R8 of FIG. 339, R1 and R2 of FIG. 341, R0 of FIG. 343, Ra, Rb and Rc of FIG. 351 and Ra and Rb of FIG. 354. It goes without saying that the above is also applicable to the built-in resistors such as FIGS. 351, 352 and 353.

In FIG. 345, the electronic regulator 501a has a first pre-charge voltage (program voltage) Va selected according to the value of VDATA1, and the electronic regulator 501b has a second pre-charge voltage (program voltage) Vb selected according to the value of VDATA2. The voltages Vpc applied to the display panel (display apparatus) are the voltages Va and Vb added by an adder 3451 comprised of the operational amplifier and so on. As described above, it is possible, by using multiple electronic regulators 501 (operating means), to generate the voltages Vpc flexibly and correspondingly to the object.

The embodiment in FIG. 345 described that the voltages Va and Vb are added to generate the voltage Vpc. However, it is not limited thereto. The voltages Va and Vb may also be subtracted or multiplied. The voltage Vpc may also be generated by three or more voltages rather than limiting to the two voltages of Va and Vb. It is not limited to the voltages but the currents such as a current Ia and a current Ib may also be generated. It may be whichever changes this current to the voltage Vpc eventually.

As described above, the pre-charge voltage (program voltage) may be generated by converting, synthesizing or manipulating multiple voltages. It goes without saying that the above is applicable likewise to the other embodiments of the present invention (for instance, FIGS. 127 to 143, FIGS. 293 to 297, FIGS. 308 to 313, FIGS. 338 to 345 and FIGS. 349 to 354).

In FIG. 342, the size of the resistor Ra or Rb of the electronic regulator 501 is changed. They are Ra1>Ra2, Ra>Rb. According to the configuration in FIG. 342, the first step of the pre-charge voltage has a large voltage difference, and the steps of the pre-charge voltage become smaller as the gradation becomes higher (on the high gradation side). It is because a large output current (=program current) can be obtained just by changing the gate terminal voltage of the driving transistor 11a a little on the high gradation side.

The resistors Rb of the intermediate or higher portions may have the same resistance (Rb1=Rb2) value. It is also possible to render them as Ra>Rb and configure them to be Ra1=Ra2=. . . , Rb1=Rb2=. . . . To be more specific, the change in the pre-charge voltage Vpc against VDATA is a curve broken at one point. As a matter of course, all the resistors R may have the same resistance value as shown in FIG. 339. In this case, the change in the pre-charge voltage Vpc against VDATA is linear. Even if it is linear, it is desirable to keep the relation of Ra1>Ra2. It is because the steps of the threshold voltage V0 and the next pre-charge voltage Vpc=voltage V1 are large.

It goes without saying that the resistors built into the source driver circuit (IC) 14 may be adjusted or processed by trimming or heating so that the resistance value thereof becomes a predetermined value.

The value of SDATA is converted to the voltage by the DA circuit 503, and is applied to the terminal b of the electronic regulator 501. It goes without saying that it may be changed in an analog fashion as shown in FIG. 311 instead of generating SDATA. It was described that the b-terminal voltage is changed according to the size of the reference current in FIG. 339. However, it is not limited thereto. It may also be the fixed current.

Generation of the voltage Vpc is not limited to being generated by the electronic regulator 501. For instance, it can also be generated by the adder consisting of the operational amplifier. It may also be configured by the switching circuit for selecting multiple voltages with a switch.

FIG. 348 shows the embodiment in which the potentials of terminals b and d are selectable with the voltages (Vc1, Vc2 and Vc3) generated outside the source driver circuit (IC) 14 by operating the switch S.

According to the present invention, a terminal V0 (the terminal for applying the 0^{th} gradation voltage or applying the voltage below the threshold voltage of the driving transistor 11a) may be common to the pre-charge circuits (program voltage generation circuits) of the RGB. However, it is desirable to have the configuration in which the voltages of the terminals b can be set independently for the RGB. FIG. 349 shows this embodiment.

According to the embodiments of the present invention, there are the cases where the operational amplifier 502 is used as an analog process circuit such as an amplifier circuit, and there are also the cases where it is used as a buffer.

In FIG. 349, the voltage V0 of the terminal a is applied in common to a pre-charge circuit (program voltage generation circuit) of R 501R, a pre-charge circuit (program voltage generation circuit) of G 501G and a pre-charge circuit (program voltage generation circuit) of B 501B. However, the terminal b has the configuration capable of applying a voltage V1R to the pre-charge circuit (program voltage generation circuit) of R 501R. In the same way, it has the configuration capable of applying a voltage V1G to the pre-charge circuit (program voltage generation circuit) of G 501G. Also, it has the configuration capable of applying a voltage V1B to the pre-charge circuit (program voltage generation circuit) of B 501B.

The embodiment in FIG. 340 is an embodiment having at least one DA circuit 503 formed, configured or placed in the electronic regulator 501. Each DA circuit 503 is controlled by two voltages (for instance, the voltages V0 and V1 for a DA circuit 503a, voltages V1 and V2 for a DA circuit 503b, voltages V2 and V3 for a DA circuit 503c, and voltages V3 and V4 for a DA circuit 503d) and a selection bit S for selecting VDATA (5:0) setting DA data and the DA circuit 503 to be operated.

Each DA circuit 503 is controlled by VDATA (5:0) and a terminal S, and outputs the voltage between the two voltages. For instance, the DA circuit 503a generates the voltage Vpc by having the terminal S1 selected. The signal for selecting the terminal S1 controls on of a switch Si. The DA circuit 503a outputs the voltage corresponding to the value of VDATA (5:0) between the voltages V0 and V1 with the value of VDATA (5:0). According to the embodiment in FIG. 340, VDATA is 6 bits so that the voltage V0−V1 is divided by 64 to output the divided unit voltage×value of VDATA (5:0)+voltage V1.

Likewise, the DA circuit 503b generates the voltage Vpc by having the terminal S2 selected. The signal for selecting the terminal S2 controls on of a switch S2. The DA circuit 503b outputs the voltage corresponding to the value of VDATA (5:0) between the voltages V1 and V2 with the value of VDATA (5:0). According to the embodiment in FIG. 340, the voltage V1-V2 is divided by 64 to output the divided unit voltage×value of VDATA (5:0)+voltage V2. The above is also applicable to the DA circuits 503c and 503d.

If configured as in FIG. 340, it is easy to implement the change in the curve of Vpc generated just by changing the voltages V0, V1, . . . , V4. To be more specific, the voltages V1, V2 and V3 of FIG. 340 control a broken position of Vpc against the gradation data (VDATA (5:0), S1, S2, S3 and S4) (a curve broken at three points in the configuration in FIG. 340). It is easy to implement the change in the size or inclination of the pre-charge voltage (program voltage) against the gradation data by changing the voltages V1, V2 and V3. It is also possible to change the position of the pre-charge voltage (program voltage) applied at the 0^{th} gradation by changing the voltage V0. It is also possible to change the maximum value for applying the pre-charge voltage (program voltage) by changing the voltage V4. It is also possible to set a more flexible pre-charge voltage (program voltage) or gamma curve by increasing the number of the DA circuits 503 and increasing the number of the input voltages (V0 to V4).

According to the embodiment in FIG. 340, the voltages V1 to V4 are supplied from outside the source driver circuit (IC) 14. However, it is not limited thereto. They may also be generated inside the source driver circuit (IC) 14. As shown in FIG. 341, it is feasible to divide the two voltages (the voltages V0 and V2) with the resistors (R1, R2) so as to generate the voltage V1.

The DA circuit 503b generates the voltage Vpc by having the terminal S1 selected. The signal for selecting the terminal S1 controls on of the switch S1. The DA circuit 503b outputs the voltage corresponding to the value of VDATA (2:0) between the voltages V0 and V1 with the value of VDATA (2:0). According to the embodiment in FIG. 341, the voltage V0-V1 is divided into eight to output the divided unit voltage×value of VDATA (2:0)+voltage V1.

The DA circuit 503c generates the voltage Vpc by having the terminal S2 selected. The signal for selecting the terminal S2 controls on of the switch S2. The DA circuit 503c outputs the voltage corresponding to the value of VDATA (4:0) between the voltages V1 and V2 with the value of VDATA (4:0). According to the embodiment in FIG. 341, the voltage V1-V2 is divided into thirty-two to output the divided unit voltage×value of VDATA (4:0)+voltage V2.

The resistor R1 or R2 or both the resistors R may also be built into the source driver circuit (IC) 14. One or both of the resistors may be variable resistors. It goes without saying that the resistor R1 and R2 may be adjusted by undergoing a trimming process. Needless to say, the above items also apply to other examples of the present invention.

FIG. 351 shows the embodiment in which three resistors (Ra, Rb and Rc) are used outside the source driver circuit (IC) 14 to generate the voltages V0 and V1. The resistors are connected to a terminal 2883 of the source driver circuit (IC) 14. The resistors Ra, Rb and Rc are connected in series between the anode voltage and the ground (GND). The voltage Va (Vdd−Va=V0) is generated at both ends of the resistors Ra, the voltage Vb is generated between the resistors Rb, and the voltage Vc (Vc=V1) is generated between the resistors Rc.

When configured as above, it is possible to set the voltages V0 and V1 freely by adjusting the resistors Ra, Rb and Rc. The configuration in FIG. 351 generates the voltages V0, V1 and so on in reference to the anode terminal voltage Vdd. Therefore, the voltages V0 and V1 change in conjunction in the case where the anode voltage Vdd changes or voltage variations of the voltage Vdd arise in a power supply module. This change coincides with an operational origin (anode terminal) of the driving transistor 11a of the pixel 16 so that good operation can be implemented.

It is also desirable to configure it as shown in FIG. 487. FIG. 487 is a deformed example (also a simplified example) of FIG. 340. FIG. 487 is an embodiment of a gamma broken at four points. However, this is intended to facilitate the description, and it may be the gamma broken at either over or below four points.

FIG. 487 is characterized in that the numbers of the pre-charge voltages Vpc between V0 and V1, V1 and V2 and V2 and V4 are not fixed. By way of example, V0 to V1 are two pieces of Vpc0 and Vpc1, V1 to V2 are 32−1=31 pre-charge voltages Vpc, V2 to V3 are 128−32=96 pre-charge voltages Vpc, and V3 to V4 are 255−32=223 pre-charge voltages Vpc. To be more specific, the numbers of the pre-charge voltages is increased as the gradation becomes higher.

As shown in FIG. 356, the pre-charge voltage V0 corresponding to gradation 0 is common to the RGB (refer to FIG. 349), and is close to the anode voltage Vdd. The pre-charge voltage V1 corresponding to gradation 1 is different according to the RGB so that the potential difference between V1 and V0 is large (refer to FIG. 356). As the voltage V1 is low-gradation, the shortage of writing is apt to occur in the current program method and the luminous efficiencies of the EL elements are low. Therefore, it is necessary to render the voltage driving dominant. For this reason, the voltages V0 and V1 are inputted from outside the source driver circuit (IC) 14 in FIG. 487.

The range from the voltages V3 to V4 is close to the ground (GND) voltage. As the program current is also large, the current driving becomes dominant so that application of the pre-charge voltages Vpc is basically unnecessary. As shown in FIG. 356, the output current is in a linear relation to a source signal line potential (gate potential of the driving transistor 11a) on the high gradation side, and so the output current is increased by a little change in the potential. Current values are also large. Therefore, accuracy of the pre-charge voltages Vpc is not necessary. For this reason, there is no problem in increasing the number of corresponding gradations between the voltages V3 to V4.

It is desirable that the potential difference between V0 and V1, potential difference between V1 and V2, potential difference between V2 and V3, and potential difference between V3 and V4 be the same or in proximity. The potential difference in proximity is within 1V. The generation circuits of the voltages V0 to V4 are simplified by rendering the potential differences in proximity, and the configuration of the electronic regulator 501 can also be simplified.

As described above, the present invention is characterized in that the numbers of the pre-charge voltages corresponding among the respective voltages V0 to V4 applied from outside (it goes without saying that they may be generated inside) are different.

The voltage V0 may be fixed even if the reference current changes. However, the position of the voltage V1 is significantly dependent on the change in the reference current ratio. It is because, as the threshold voltage of the driving transistor 11a of the pixel 16 is small, it is necessary to significantly change the gate terminal potential of the driving transistor 11a (potential of the source signal line 18 during the program) correspondingly to the reference current ratio. In the case where the driving transistor 11a is the P-channel transistor, it is necessary to lower the potential of the source signal line 18 as the reference current ratio becomes larger. The change in the voltage according to the reference current ratio should render the voltage V4 larger than the voltage V2.

As described above, the present invention is characterized in that, in the case of performing the drive for changing the reference current ratio, the potential of the voltage V1 onward or the voltage V2 onward is changed while keeping the voltage V0 fixed or maintaining the potential in proximity to the predetermined voltage. In the case where the driving transistor 11a is the N-channel transistor, the voltage V0 (threshold voltage) is located on the GND potential side.

Therefore, the potential relation in FIG. 487 should be changed to the one for the N-channel. As the change is easy to those skilled in the art, the description thereof will be omitted. According to the present invention, although driver transistors 11a are cited hereinbefore as P-channel transistors, this is not restrictive. N-channel transistors may be used instead.

FIG. 487 has the configuration in which the built-in resistors of the source driver circuit (IC) 14 are formed or placed between the voltages V0 and V1. As a matter of course, the resistors R may be external resistors. The resistance values of the resistors R may be adjusted by the trimming.

The voltage V0 is fixed. If it does not work with the voltages V1 and V2, there is no need to form the resistors R as shown in FIG. 491. As the potential difference is relatively large between the voltages V0 and V1, it is necessary to form large resistors between the voltages V0 and V1. The large resistors increase the number of parts of the resistors, which directly leads to enlargement of the size of a source driver circuit (IC) 14 chip.

In FIG. 491, the voltages V0 and V1 are independent in order to solve this problem. To be more specific, the resistors are not formed between voltage terminals V0 and V1. The resistors are not formed between voltage terminals V1 and V2, either. The resistors are placed between voltage terminals V2 and V8, and the resistors eight times the resistors R (8R) are formed between one pre-charge voltage terminals, such as between Vpc2 and Vpc3, between Vpc3 and Vpc4, and between Vpc4 and Vpc5. It is because, as the potential difference is relatively large between the voltage terminals V2 and V3 and so a lot of through current passes to further increase the power consumption if the number of the formed resistors R is small.

The resistors are placed between voltage terminals V8 and V32, and the resistors four times the resistors R (8R) are formed between one pre-charge voltage terminals, such as between Vpc8 and Vpc9, between Vpc9 and Vpc10, and between Vpc10 and Vpc11. It is because, as the potential difference is relatively large between the voltage terminals V8 and V32 and so a lot of through current passes to further increase the power consumption if the number of the formed resistors R is small. The resistors R are placed between Vpc terminals between V32 and V128 voltage terminals. The configuration with one-part resistors is possible because the number of the pre-charge voltage terminals formed between voltage terminals V32 and V128 is large and so the number of the configured resistors R is also large so as to have no through current passing. The above is also applicable. likewise to the case between voltage terminals V128 and V255.

If the voltage terminals are configured to correspond to the gradations of four times such as the voltages V2, V8, V32 and V128 as in the embodiment in FIG. 491, it is possible, as shown in FIG. 492, to configure a pre-charge voltage circuit of a broken line gamma. The potential difference between the voltages V2 and V8, potential difference between the voltages V8 and V32, potential difference between the voltages V32 and V128 and potential difference between the voltages V128 and V255 are almost equal. And the broken line gamma of FIG. 492 matches with the V-I characteristic of the driving transistor 11a.

As described above, it is possible to implement good pre-charge driving (pre-charge voltage+program current driving) by having the configuration in the embodiments in FIGS. 491 and 492. It is possible, with the pre-charge voltage outputted from the circuit configuration in FIGS. 491, to make a change in proximity to the target source signal line 18 and correct a slight amount of displacement with the program current so as to implement the image display of which uniformity is very good (refer to FIGS. 127 to 142).

The configuration in FIGS. 491 is the embodiment of seven voltage terminals of V0, V1, V2, V8, V32, V128 and V255. However, the present invention is not limited to this. For instance, FIGS. 493 are the embodiment of 512 gradations and shows voltage terminal positions. FIG. 493(a) describes the terminal positions as 0, 1, 2, 4, 8, 32, 128 and 512. To be more specific, it is the embodiment having formed the voltage terminal V0, voltage terminal V1, voltage terminal V2, voltage terminal V8, voltage terminal V32, voltage terminal V128 and voltage terminal V512.

FIG. 493(b) describes the terminal positions as 0, 1, 8, 32, 128, and 512. To be more specific, it is the embodiment having formed the voltage terminal V0, voltage terminal V8, voltage terminal V32, voltage terminal V128, and voltage terminal V512. FIG. 493(c) describes the terminal positions as 0, 1, 2, 8, 32, and 128. To be more specific, it is the embodiment having formed the voltage terminal V0, voltage terminal V1, voltage terminal V2, voltage terminal V8, voltage terminal V32,and voltage terminal V128. As a matter of course, they just have to be in the proximity, and may be the voltage terminal V0, voltage terminal V1, voltage terminal V3, voltage terminal V7, voltage terminal V31 and voltage terminal V127 for instance.

As described above, according to the present invention, at least a set of voltage terminals are multiples of 4 or in proximity thereto. As for the multiple of 4, it is different depending on whether it is started from the 0^{th} gradation or the 1^{st} gradation. For instance, FIGS. 493 comprise V0, V1, V2, V8, V32 and V128, which may also be V1, V2, V7, V31 and V127. To be more specific, Vn/Vn−1 should be in proximity to 4. For instance, V127/V31 is in proximity to 4, and so it is in the technical category of the present invention. Even in the case of V1, V3, V12, V31 and V255, it is in the technical category of the present invention because the relation between V12 and V3 as one combination, that is V12/V3, is 4.

It is desirable to configure the potential differences among the voltage terminals to be changeable by the reference current ratio. FIGS. 494 shows the embodiment in which they are changeable among the voltage terminals by the voltage regulator VR. As a matter of course, they may be changed by a DA converter 501 instead of the VR. The resistors R0 to R6 are placed between the voltage Vdd and GND. The terminal voltage of the resistor R6 is changed by the voltage regulator VR along with the change in the reference current ratio. The voltages of the resistors R0 to R6 are changed by the voltage regulator VR. This change leads to the change in the voltages of the voltage terminals V1 to V256. As the voltage V0 is the voltage of gradation 0, it is fixed at the predetermined voltage Va. The potentials of the voltage terminals V1 to V256 are applied to multiple source driver circuits (IC) 14 in common.

The embodiment described that the voltage terminals V1 to V256 are changed correspondingly to the reference current ratio. However, it goes without saying that they may be changed according to other changes such as the lighting rate.

The embodiment in FIG. 494 has the configuration in which the voltage applied to the voltage terminal is changed by the external resistor R of the source driver circuit (IC) 14. However, the present invention is not limited thereto. For instance, it is also possible, as shown in FIG. 495, to have the predetermined voltage applied between the voltage terminals (between the voltages V2 and V8, between the voltages V8 and V32 and between the voltages V32 and V128) by the built-in resistor Ra of the source driver circuit (IC) 14.

The voltages V1 and V2 are separated in FIG. 495. As shown in FIG. 496, however, it goes without saying that the voltage V1 may be the pre-charge voltage Vpc1, and the pre-charge voltage Vpc2 onward may be generated via the operational amplifier 502c.

In FIG. 487, it is described that the resistors R of the electronic regulator 501 are the same. It is possible to miniaturize IC chips by equalizing the resistance values of the resistors R. However, the present invention is not limited thereto. The resistors R maybe varied. For instance, it is possible to increase the resistance value on the low gradation side (because the potential difference of the potential corresponding to the gradation is large in the V0 to low gradation region as shown in FIG. 356) and decrease the resistance value on the high gradation side relatively or by the absolute value. The resistance values of the resistor may consist of two kinds of the low gradation side and high gradation side or multiple kinds. The above is also described in FIGS. 136, 137, 341 and 342, and so a description thereof will be omitted.

For instance, to generate the gamma curve shown in FIG. 492, the resistance value placed between the pre-charge voltage Vpc terminals has the square-law characteristic. An example of the above configuration is shown in FIG. 497. As for the voltage between the pre-charge voltage Vpc terminals, the resistance values are changed, such as 1, 3, 5, 7, 9, . . . .

In FIG. 497, it is possible to generate proper pre-charge voltages by changing the voltages V1, V2 and so on. A DA circuit 501a may be used for the change in the voltages as shown in FIG. 498. The DA circuit 501a is controlled by an 8-bit data ID outputted by the controller circuit (IC) 760.

As shown in FIG. 503, it is possible to generate a constant current Ir in a constant current circuit consisting of the transistors 158 and the operational amplifier 502 and pass this current Ir to the resistors R of the electronic regulator so as to render the pre-charge voltage Vpc variable. A resistor Ir is changed by the voltage regulator VR.

The embodiment was described as the embodiment of the pre-charge driving method. However, the present invention is not limited thereto. It goes without saying that it is also applicable to the voltage driving method (for instance, the driving method of the EL display panel having the pixel configuration of FIG. 2). As for the voltage driving, independent gamma circuits for the RGB are required because the gamma curves of the EL elements of the RGB are different.

It is also possible to have the configuration in FIG. 527 by combining the configurations in FIG. 491 and 497. FIG. 527 changes the resistance values between taps of the voltages V1 and V2 to 4R, 2R and R rather than fixed resistors. The curve in FIG. 492 becomes curved by making the change so as to match better with the V1 characteristic of the driving transistor 11a. It goes without saying that a combination may also be made with the embodiments of FIGS. 131 to 142.

FIG. 525 has the configuration in which the digital data is inputted to a voltage input terminal (voltage input tap) and the voltage is generated by a DA converter 501a. FIG. 525 has the configuration, by way of example, in which the digital data consisting of 8-bit V2DATA is applied to the terminal to which the voltage V2 is inputted. It is also the configuration in which the digital data consisting of 8-bit V3DATA is applied to the terminal to which the voltage V3 is inputted. It is possible to render the data applied to the terminal variable as the digital data so as to set or vary the curve in FIG. 492 freely. It is possible to vary or set the curve in FIG. 492 correspondingly to the lighting rate or according to the temperature or the ratio between moving images and static images.

As described above, the circuit configuration for generating the pre-charge voltage in the source driver circuit (IC) 14 includes a wide variety of configurations. It goes without saying that the above is also applicable to the circuit configuration for generating the pre-charge current or an overvoltage Id.

FIG. 499 shows the embodiment in which the pre-charge voltage circuit of the present invention previously described is applied to the voltage driving method. The voltage V0 of the RGB is common. An electronic regulator 501R is the voltage generation circuit of R. An electronic regulator 501G is the voltage generation circuit of G. An electronic regulator 501B is the voltage generation circuit of B. It is possible to generate RGB independent gamma curves by having the configuration in FIG. 499 so as to implement a good white balance.

As described above, it goes without saying that the circuit configurations and driving methods of generating the pre-charge voltage of the present invention are also applicable to the voltage driving method. To be more specific, they are not limited to the voltage+current driving.

In FIG. 487, it is described that the pre-charge voltage Vpc is corresponding to the entire gradation range. However, the present invention is not limited thereto. It is also possible, limiting it to the regions short of the writing current or writing voltage, to configure or place a pre-charge voltage Vpc generation circuit. For instance, it is the current driving in FIG. 487, where the shortage of writing (presumably) occurs in the low gradation region. Therefore, it goes without saying that the pre-charge voltage generation circuit is configured as to V0 to V128 falling under the low gradation and is omissible over that. It goes without saying that the corresponding gradations may be intermittent, such as configuring the pre-charge voltage generation circuit at the 0^{th} gradation and even-numbered gradations. The pre-charge voltage over gradation 128 may be only Vpc 255. It is because the program current works dominantly. It goes without saying that the above is also applicable to the other embodiments of the present invention.

FIGS. 339 and 341 have the configuration in which the potential at the point b is variable. It is because the driving method of the present invention required to vary the potential at the point b varies the reference current (as for the method of changing or controlling the reference current, refer to FIGS. 61, 63, 64, 93 to 97, 111 to 116, 122, 145 to 153, 188, 252, 254, 267, 269, 277, 278 and 279 as well as descriptions thereof) FIG. 350 shows the relation between the gate terminal voltage (horizontal axis) and the output current (vertical axis) of the driving transistor 11a. The vertical axis indicates the program current Iw. The program current Iw is proportional to the reference current. The gate terminal voltage of the horizontal axis indicates the potential of the source signal line 18. The potential of the source signal line 18 is the same as the pre-charge voltage (program voltage).

In view of the above, FIG. 350 shows that, when the reference current Ic is I1 and the maximum program current (at the highest gradation) flows from the source signal line 18, it is necessary to apply the pre-charge voltage (program voltage) so that the potential of the source signal line 18 becomes V1. In the same way, when the reference current Ic is I2 and the maximum program current (at the highest gradation) flows from the source signal line 18, it is necessary to apply the pre-charge voltage (program voltage) so that the potential of the source signal line 18 becomes V2. When the reference current Ic is I3 and the maximum program current (at the highest gradation) flows from the source signal line 18, it is necessary to apply the pre-charge voltage (program voltage) so that the potential of the source signal line 18 becomes V3.

Here, the reference current Ic changes three times as much from I1 to I3. To be more specific, it is I3 : I2 : I1=3:2:1. In this case, optimum values of V3, V2 and V1 are V3:V2:V1=11.5: 11:10 as a result of examination. To be more specific, the change in the pre-charge voltage Vpc is little even if the change in the reference current is three times. In view of the above, the change in Vpc may be small. As for the relation between a change in the pre-charge voltage Kv (V3/V1 in FIG. 350) and a change in the reference current Ki (I3/I1 in FIG. 350), it is desirable to maintain the relation of 2<Ki/Kv<3.5.

Even in the case where the value of the reference current I changes significantly from FIG. 350, the change in the pre-charge voltage is small. Therefore, the voltage V1 in FIGS. 339 and 341 changes just by a small amount even if the reference current changes significantly. For that reason, it is sufficient even if an output change of the DA circuit 503 is small. In FIGS. 339 and 341, the voltage V1 is changed according to the reference current. However, as in the embodiment in FIGS. 351, there is no problem arising from a practical viewpoint even if the voltage of a terminal 2883c is fixed. On the contrary, the variable range of the maximum pre-charge voltage (program voltage) can be small so as to simplify the circuit configuration. And highly accurate output becomes possible.

The shortage of writing of current occurs in the low gradation region in the case of the current driving method. And the region in which the shortage of writing occurs is a section A which is from the voltage V0 (0^{th} gradation: the threshold voltage of the driving transistor 11a) to Vx in FIG. 350. This range shows a linear change as described by the dotted line. In FIG. 350, the inclination is represented as a small one in the section indicated by A. From a practical viewpoint, it is sufficient for such an inclination to be smaller than the curve in full line. It is because, as for the method of applying the program current after performing the voltage application (pre-charge voltage (program voltage) application) described in FIGS. 127 to 143, a complete correction can be implemented by the program current even if there is a difference between the potential of the source signal line 18 completely corrected and the potential of the source signal line having the pre-charge voltage applied thereto (appearing as a current difference in full line and dotted line in FIG. 350).

It is important to apply the pre-charge voltage (program voltage) to the source signal line 18 and set or adjust it to proximity to an ideal source signal line 18 potential (gate terminal potential of the driving transistor 11a implemented by the program current) in a short time ( 1/200 to 1/20 of 1H). This operation reduces the potential difference changed from the ideal (compensated) source signal line 18 potential to the source signal line 18 implemented by the program current. Therefore, even a relatively small program current (program current in the low gradation region) can implement an ideal state (a current program compensating for the characteristics of the driving transistor 11a can be implemented). In the high gradation region, the size of the program current is large, and so the ideal state can be achieved (implemented) just by the program current without applying the pre-charge voltage (program voltage).

In view of the above, the range in which the shortage of writing occurs is limited to the low gradation region. The pre-charge voltage (program voltage) is not necessary in the high gradation region (the pre-charge voltage may be applied as a matter of course). The region to have the pre-charge voltage (program voltage) applied is not required to be in the entire gradation range but is sufficient to be the half-tone or lower region. It is possible, by limiting the range of the regions to have the pre-charge voltage applied to the half-tone or lower region, to reduce the number of taps of the electronic regulator in FIGS. 131, 135 to 142, 339 to 341, 351 and 353. Therefore, it is possible to simplify the circuits and realize reduction in costs.

It is possible, by having the configuration for generating the pre-charge voltage (program voltage) correspondingly to the dotted line shown in FIG. 350, to configure the resistors of the electronic regulator 501 by placing the resistors of the same resistance value. Therefore, the circuit configuration of the electronic regulator 501 becomes simple, which is desirable.

As shown in FIG. 359, however, it is desirable as an ideal that the output current I due to the application of the pre-charge voltage (program voltage) have regular intervals (regular steps). The differences between the voltage 0 and the voltage V0, and between the voltage V0 and the voltage V1 are large. The differences between the voltage V4 and the voltage V5 is small. To implement such steps (graduations), the size of the resistors of electronic regulator 501 should be changed.

It is desirable to match voltage gradation data for setting (specifying) the pre-charge voltage (program voltage) with current gradation data for setting (specifying) the program current. If the video data is at gradation 128, the voltage gradation data should also be at 128 and the current gradation data should also be at 128. To be more specific, it should be the number of video data after performing gamma conversion=the number of voltage gradation data=current gradation data (deciding and operating the switch S of the electronic regulator 501 in FIGS. 131, 339 and 351 based on the number of video data, and applying the pre-charge voltage (program voltage) Vpc to the source signal line 18. The on and off state of the switches 151 in FIG. 15 is decided based on the number of video data so as to operate the current gradation circuit 164 or a unit transistor group 431c.

As for whether or not to apply the pre-charge voltage (program voltage) to each of the video data, it is controlled by the controller circuit (IC) 760 and controlled by a pre-charge bit (refer to FIGS. 75 to 79 and the descriptions thereof). As for whether or not to apply the pre-charge voltage (program voltage), it is determined based on a potential state of the source signal line 18 (an application state of the pre-charge voltage (program voltage) immediately before writing to each pixel) or the size of the video data (the pre-charge voltage (program voltage) is applied in the low gradation region). Therefore, there are the cases where the pre-charge voltage (program voltage) is not applied even in the case of the video data in the low gradation region.

There are also the cases where the pre-charge voltage (program voltage) is applied even in the case of the video data in the high gradation region. The present invention is characterized by containing the bit for determining the pre-charge voltage (program voltage) in the source driver and having the methods of determining whether or not to apply the pre-charge voltage (program voltage) or controlling the pre-charge voltage (program voltage) correspondingly to the video data (gradation) or the technical idea thereof.

It is possible, by having the configuration or exerting control as above, to facilitate the configuration of the source driver circuit (IC) 14 and reduce the data transmitted from the controller circuit (IC) 760 to the source driver circuit (IC) 14 (only the video data is necessary and the number of voltage gradation data and the current gradation data are not necessary) so as to reduce frequencies of transmission data.

It is desirable to set the number of selectable voltages Vpc at ⅛ or more of the number of gradations of the display apparatus (32 gradations or more in the case of 256 gradations) in the case where the display apparatus is 6 inches or larger. In particular, it is desirable to set it at ¼ or more (64 gradations or more in the case of 256 gradations). It is because the shortage of writing of the program current occurs up to a relatively high gradation region. As previously described, however, it is not necessary to configure or form it to be able to apply the pre-charge voltage (program voltage) in the entire gradation range.

In the case of a relatively small display panel (apparatus) below 6 inches, it is desirable to set the number of selectable voltages Vpc at 2 or more. It is because there are the cases where it is difficult to perform the gradation display in the low gradation region while a good black display can be implemented with only one voltage Vpc of V0. If there are two or more voltages Vpc, it is possible to generate multiple gradations by FRC control so as to implement a good image display.

It is desirable to change the pre-charge voltage (program voltage) with the voltages (Vgh1, Vgl1) controlling the gate signal line 17a. In particular, the pre-charge voltage (program voltage) is changed by the voltage Vgl1. It is because the gate terminal potential of the driving transistor 11a changes due to the parasitic capacitance of the gate terminal of the driving transistor 11a and amplitude of the voltage Vgl1.

As shown in FIG. 355, the threshold voltage of the driving transistor 11a changes as the voltage Vgl1 becomes lower. For instance, when Vgl1=0V, the threshold voltage (the pre-charge voltage (program voltage)) applied as the 0^{th} gradation) is V2. When Vgl1 =−4V, the threshold voltage (the pre-charge voltage (program voltage)) applied as the 0^{th} gradation) is V1. And when Vgl1=−9V, the threshold voltage (the pre-charge voltage (program voltage) applied as the 0^{th} gradation)) gets closer to V0 and the anode voltage (Vdd in FIG. 355). Therefore, it is desirable to change the voltage V0 in FIG. 339 in conjunction with the voltage Vgl1. It is also desirable to change the voltage V1.

It goes without saying that the above is applicable to the other embodiments of the present invention. It also goes without saying that the above technical idea is applicable to the display apparatus, display panel and display method of the present invention.

FIG. 352 is a deformation example of FIG. 351. In FIG. 352, the resistors Ra and Rb are built into the source driver circuit (IC) 14. The voltage Vdd is applied to a terminal 2883b, and the resistor Rc is connected between the terminal 2883c and the ground. The external resistors become one by configuring them as in FIG. 352. However, it is desirable to render the value of the resistor Rc individually settable for each of the RGB. It goes without saying that the voltage may be directly inputted to the terminal 2883c. It is also possible to build the resistor Rc into the source driver circuit (IC) 14.

The resistor Ra may be adjusted by trimming and so on. In the case where the resistor is comprised of a diffused resistor, it is also possible to adjust the resistance value by heating. It is also possible to configure it on the electronic regulator or a resistance switch circuit so as to set or adjust it to the predetermined resistance value. It goes without saying that the above is applicable to the other embodiments such as FIGS. 352 and 353. FIG. 352 describes an adjustment of the resistor Ra as the embodiment. FIG. 353 describes an adjustment of the resistor Rb as the embodiment.

In FIG. 353, the voltage Vdd is applied to a terminal 2883b and the external resistor Rc is connected to the terminal 2883c. The potential difference between the potential of the point a and the potential of the point b is set by adjusting the resistor Rb. The potential of the terminal b is adjusted by adjusting the value of the resistor Rc.

The configuration in FIG. 354 is shown as the embodiment for adjusting the voltage V1 with the reference current Ic. FIG. 354 has the configuration in which the reference current Ic (or the current Ic relative or proportional to the reference current Ic) flows into the external resistor Rb. Therefore, the voltage Vb of the terminal 2883b is resistor Rb×Ic. This voltage becomes the gate terminal voltage of the transistor 158b. The transistor 158b has the channel-to-channel voltage (SD voltage) generated by the voltage Vb and the current Ib flowing to the external resistor Ra. The voltage V1 of the terminal 2883a is Vdd−Ra×Ib. Therefore, the change in the size of the reference current Ic is the change in the voltage V1. The operation of the electronic regulator 501 was previously described, and so a description thereof will be omitted.

It goes without saying that the above is applicable to the other embodiments of the present invention. For instance, they are exemplified by FIGS. 127 to 143, FIGS. 293 to 297, FIGS. 308 to 313, FIGS. 338 to 345 and FIGS. 349 to 354. It goes without saying that the contents described in the embodiments can constitute the embodiments by selecting, getting compound or combined with the respective embodiments.

It goes without saying that the resistance values of the resistors built into the source driver circuit (IC) 14 may be adjusted or processed by trimming or heating so that the resistance values will become the predetermined value. This is applicable likewise to the external resistors.

In FIG. 293 (it may be another embodiment), the resistance array 2931 (resistors R) is built into the IC chip 14 or the source driver circuit (IC) 14. However, it is not limited thereto. It goes without saying that it may be externally mounted on the source driver circuit (IC) 14 with a discrete component. The pre-charge voltage (synonymous with or similar to the program voltage) Vpc is not limited to being generated by using the resistor R but may also be configured with another component such as the operational amplifier or transistor. It goes without saying that the pre-charge voltage (synonymous with or similar to the program voltage) Vpc may be configured, formed or made to generate a constant voltage like a pulse by PWM modulation and smooth it with the capacitor so as to obtain the predetermined voltage. The pre-charge voltage (synonymous with or similar to the program voltage) Vpc is not limited to being generated in the IC (circuit) 14. It is possible to have the configuration for selecting the pre-charge voltage (synonymous with or similar to the program voltage) Vpc generated outside the IC (circuit) 14, inputted from the terminal of the IC (circuit) 14 and adapted by the switch in the IC (circuit) 14.

It goes without saying that, with the control data of the controller circuit (IC) 760, the pre-charge voltage (synonymous with or similar to the program voltage) Vpc may be configured to be generated outside the IC (circuit) 14, taken inside the terminal of the IC (circuit) 14 and applied to the source signal line 18 and so on. It goes without saying that the above is applicable to the other embodiments of the present invention, such as FIGS. 127 to 143, FIGS. 293 to 297, FIGS. 308 to 313, FIGS. 338 to 345 and FIGS. 349 to 354.

As described in FIGS. 127 to 143, FIGS. 293 to 297, FIGS. 308 to 313, FIGS. 338 to 345 and FIGS. 349 to 354, the present invention applies the pre-charge voltage (synonymous with or similar to the program voltage) (voltage data) and applies the program current thereafter. The FRC technology is used for the program current Iw in order to increase gradation properties. In general, 10-bit data is represented by 8 bits of 4FRC.

According to the present invention, the pre-charge voltage is also rendered as FRC as shown in FIGS. 313. For instance, FIG. 313(b) shows the driving method of 4FRC. In FIG. 313(b), a white ∘ (white circle) indicates that the pre-charge voltage (synonymous with or similar to the program voltage) is applied (outputted), and a black ∘ (black circle) indicates that the pre-charge voltage (synonymous with or similar to the program voltage) is not applied. To be more specific, FIG. 313(b)(1) shows that the pre-charge voltage (synonymous with or similar to the program voltage) is applied only once in the four frames (fields).

Similarly, FIG. 313(b)(2) shows that the pre-charge voltage (synonymous with or similar to the program voltage) is not applied only twice in the four frames (fields), and FIG. 313(b)(3) shows that the pre-charge voltage (synonymous with or similar to the program voltage) is applied three times in the four frames (fields). FIG. 313(b)(4) shows that the pre-charge voltage (synonymous with or similar to the program voltage) is applied in all the four frames (fields).

It is possible, by implementing the above operation (method), to increase the gradation display by means of the pre-charge voltage (synonymous with or similar to the program voltage). Accordingly, the number of the gradation increases so that the proper pixel display may be achieved. To be more specific, the gradation display is mainly implemented by the pre-charge voltage (synonymous with or similar to the program voltage) in the low gradation region, and is implemented by the program current in the high gradation region.

Needless to say, this may apply to the other embodiments as shown in, for example, FIGS. 127-143, 293-297, 308-313, 338-345 and 349-354 in the present invention.

Application of the pre-charge voltage (synonymous with or similar to the program voltage) prevents occurrence of the flicker. Therefore, it is desirable to change timing for applying the pre-charge voltage (synonymous with or similar to the program voltage) as shown in FIG. 313(c) (the embodiment for applying the pre-charge voltage (synonymous with or similar to the program voltage) twice in 4FRC).

In the low gradation region, it is possible to charge and discharge the source signal line 18 in a short time with the voltage data (VDATA) such as the pre-charge voltage (synonymous with or similar to the program voltage). The current data (IDATA) such as the program current Iw takes time to charge and discharge the source signal line 18 up to the target voltage (current). Therefore, it is necessary to make the operation for rendering it as the current of the EL element 15 as a common target stronger in the current program.

Thus, as shown in FIG. 313(a), the current data (IDATA) is the data of a high gradation at gradation 1 (for instance, while it is originally IDATA=1 at gradation 1, it is set at 4 so as to pass the current four times as much). The pre-charge voltage (synonymous with or similar to the program voltage) (VDATA) is 1 (original value). Similarly, the current data (IDATA) is the data of a high gradation at gradation 2 (for instance, while it is originally IDATA=2 at gradation 2, it is set at 6 so as to pass the current three times as much). The pre-charge voltage (synonymous with or similar to the program voltage) (VDATA) is 2 (original value).

It is possible, by making the current data a large value, to implement a highly accurate program. As for the half-tone or higher, the current data and the voltage data are the same (IDATA=VDATA=k at gradation k) or no voltage data is applied.

It goes without saying that the potential c or potential d may be changed by the lighting rate, anode current and duty ratio. It goes without saying that the above is also applicable to the technical idea of FRC shown in FIGS. 313. Also, this may apply to the other embodiments as shown in, for example, FIGS. 127-143, 293-297, 308-313, 338-345 and 349-354 in the present invention.

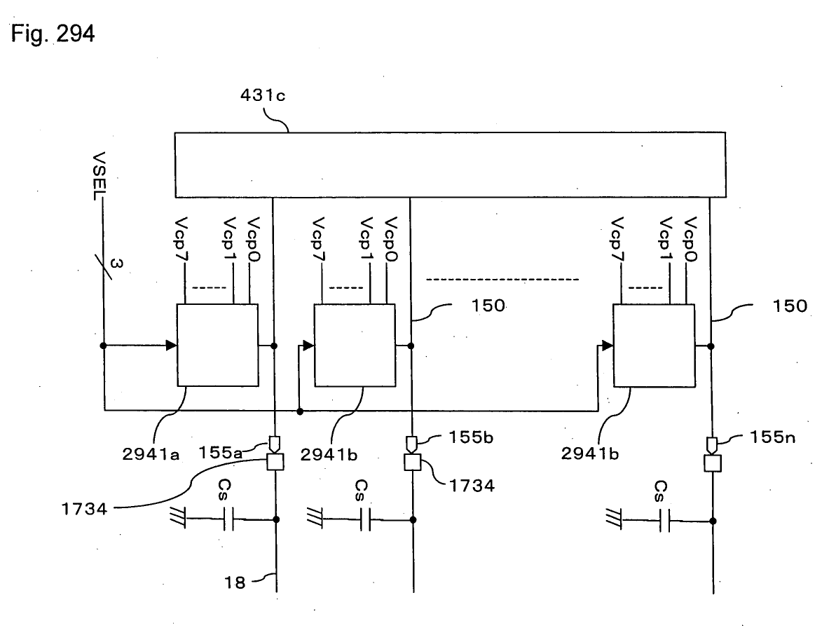

FIG. 294 is a schematic diagram centering on a circuit portion for selecting the pre-charge voltage (synonymous with or similar to the program voltage) Vpc. The output of the resistance array 2931 is inputted to a voltage selector circuit 2941. The voltage selector circuit 2941 is comprised of an analog switch and a decoder circuit, where one pre-charge voltage (synonymous with or similar to the program voltage) is applied by a 3-bit signal of a selection signal VSEL (refer to FIG. 296). A selected pre-charge voltage (synonymous with or similar to the program voltage) is outputted from the terminal 155 via a wiring 150.

The pre-charge voltage (synonymous with or similar to the program voltage) outputted from the terminal 155 is held by Cs which is the parasitic capacitance of the source signal line 18. Therefore, a dot sequential operation may be performed in outputting the pre-charge voltage (synonymous with or similar to the program voltage). However, in the dot sequential operation, the duration of application of the pre-charge voltage (synonymous with or similar to the program voltage) of the terminal 1 and is different from that of the terminal n (the final terminal).

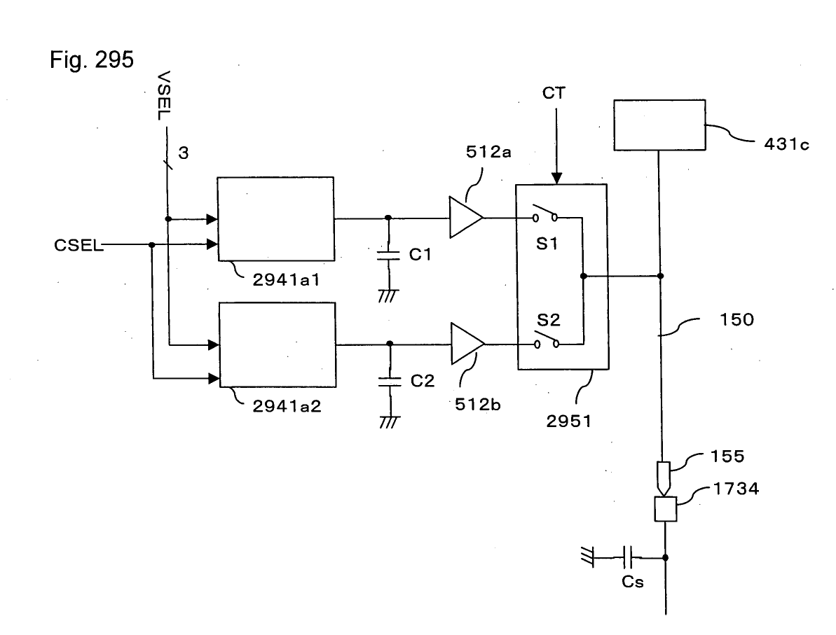

As for this problem, two voltage selector circuits 2941 should be formed or configured as shown in FIG. 295. In the first H period, a voltage selector circuit 2941a outputs, and the pre-charge voltage (synonymous with or similar to the program voltage) held by C1 is, by having the switch S1 of the selector circuit 2951 selected, the selected pre-charge voltage (synonymous with or similar to the program voltage) Vpc is outputted from the terminal 155. In this period (first H period), a voltage selector circuit 2941a2 operates sequentially, and the selected pre-charge voltage (synonymous with or similar to the program voltage) Vpc is held by C2. The switch S2 of the selector circuit 2951 is open.

In the second H period following the first H period, the pre-charge voltage (synonymous with or similar to the program voltage) outputted by a voltage selector circuit 2941b and held by C2 is outputted from the terminal 155 via the switch S1 of the selector circuit 2951. In this period (second H period), a voltage selector circuit 2941a1 operates sequentially, and the selected pre-charge voltage (synonymous with or similar to the program voltage) Vpc is held by Cl. The switch S1 of the selector circuit 2951 is open.

In FIG. 351, an open terminal is provided in the electronic regulator 501. However, it is intended to facilitate the description, and it is not necessarily limited to being configured or formed in the electronic regulator 501. As shown in FIG. 387 for instance, in the case of the mode (driving method) for placing or forming the switch 151b (selector circuit) on the output side of the voltage output circuit 1271 of the program voltage (pre-charge voltage) to output the pre-charge voltage from the terminal 155, the switch 151b may be installed on the terminal a side, and the switch 151b may be installed on the terminal b side (not selecting the terminal a) in another mode.

Similarly, in the third H period following the second H period, the pre-charge voltage (synonymous with or similar to the program voltage) outputted by a voltage selector circuit 2941a and held by C1 is outputted from the terminal 155 via the switch S1 of the selector circuit 2951. In this period (third H period), a voltage selector circuit 2941a2 operates sequentially, and the selected pre-charge voltage (synonymous with or similar to the program voltage) Vpc is held by C2. The switch S2 of the selector circuit 2951 is open. In the fourth H period following the third H period, the pre-charge voltage (synonymous with or similar to the program voltage) outputted by a voltage selector circuit 2941b and held by C2 is outputted from the terminal 155 via the switch S1 of the selector circuit 2951. In this period (fourth H period), a voltage selector circuit 2941a1 operates sequentially, and the selected pre-charge voltage (synonymous with or similar to the program voltage) Vpc is held by C1. The switch S1 of the selector circuit 2951 is open. The above action is repeated in order.

FIG. 308 is another embodiment of the present invention for outputting the pre-charge voltage (synonymous with or similar to the program voltage). The switch of the electronic regulator 501 operates according to VDATA for selecting or deciding the pre-charge voltage (synonymous with or similar to the program voltage), and a relevant pre-charge voltage (synonymous with or similar to the program voltage) Vpc is held by a capacitor Cc. The held pre-charge voltage (synonymous with or similar to the program voltage) Vpc is held by a sampling circuit 862, and is held by outputs Ca to Cn selected by address data PADRS of the source signal line 18 as an output destination. The specified data of PADRS changes in synchronization with the dot clock CLK. VDATA is changed corresponding to the video data (refer to the descriptions of FIGS. 127 to 143).

Therefore, the pre-charge voltage (synonymous with or similar to the program voltage) Vpc is held by holding capacitors Ca to Cn corresponding to the output terminals for the 1H period. When applying the pre-charge voltage (synonymous with or similar to the program voltage) to the source signal line 18, switches Sp are closed all together for a fixed period. In this case, the switches Si are rendered open so as to prevent the pre-charge voltage (synonymous with or similar to the program voltage) Vpc from flowing back to a current circuit 431c. The pre-charge voltage (synonymous with or similar to the program voltage) Vpc is selected by the voltage selector circuits 2941 in FIG. 295. Selection data may be performed by the latching circuit 771. This is the same as to the embodiment in FIG. 308. It goes without saying that FIG. 308 should desirably have a two-stage configuration as shown in FIG. 295.

FIG. 308 has the circuit configuration for sample-holding the pre-charge voltage (synonymous with or similar to the program voltage). However, the present invention is not limited thereto. It is also possible, as shown in FIG. 309, to generate multiple pre-charge voltages (synonymous with or similar to the program voltage) and make a selection.

It is possible, in FIG. 309, to select Vpa and Vpb which are fixed and Vpc which is arbitrarily changeable by the voltage regulator (VR) as the pre-charge voltages (synonymous with or similar to the program voltages). The pre-charge voltage (synonymous with or similar to the program voltage) is selected by a 2-bit selector signal (SEL). The switch Sp for selecting the pre-charge voltage (synonymous with or similar to the program voltage) is selected by the SEL signal. As shown in the table of FIG. 309, none of the pre-charge voltages (synonymous with or similar to the program voltages) is selected when the SEL is 0. To be more specific, no pre-charge voltage (synonymous with or similar to the program voltage) is applied to the source signal line 18. When the SEL is 1, the switch Sp1 is selected and the pre-charge voltage (synonymous with or similar to the program voltage) Vpa is applied to the source signal line 18. When the SEL is 2, the switch Sp2 is selected and the pre-charge voltage (synonymous with or similar to the program voltage) Vpb is applied to the source signal line 18. When the SEL is 3, the switch Sp3 is selected and the pre-charge voltage (synonymous with or similar to the program voltage) Vpc is applied to the source signal line 18.

In FIG. 309, current program data (DATAa, DATAb) of the current output circuit is held by the latching circuit 771, and is switched at each 1H. To be more specific, a latching circuit 771a is selected at the first H, in which period the data is sequentially held by a latching circuit 771b in synchronization with the dot clock. A latching circuit 771b is selected at the second H, in which period the data is sequentially held by a latching circuit 771a in synchronization with the dot clock. The held data is switched by switches Sa (Saa, Sab) in synchronization with a horizontal synchronizing signal, and the output current (such as the program current) of the unit transistor group 431c is confirmed.

FIG. 310 mainly shows the configuration of FIG. 309 in a more concrete fashion. Pre-charge voltage (synonymous with or similar to the program voltage) wirings PS (PSa, PSb, PSc and PSd) for transmitting the pre-charge voltages (synonymous with or similar to the program voltages) Vp (Vpa, Vpb, Vpc, open) are installed to be orthogonal to the source signal lines 18. The pre-charge voltage (synonymous with or similar to the program voltage) wirings PS are orthogonal to the internal wiring 150, where the switch Sp is placed at each intersection. The switches Sp can be switched by the SEL signal as shown in FIG. 309. The pre-charge voltages (synonymous with or similar to the program voltages) are applied to all the source signal lines 18 all together in the first 1H period. Therefore, it is also necessary to latch and hold the SEL signal.

The embodiment applies the pre-charge voltage (synonymous with or similar to the program voltage) via the source driver circuit (IC) 14. However, the present invention is not limited thereto. For instance, it is also possible to form a transistor element for the pre-charge voltage (synonymous with or similar to the program voltage) formed on the array 30 and control on and off of the transistor element so as to apply the pre-charge voltage (synonymous with or similar to the program voltage) applied to the pre-charge voltage (synonymous with or similar to the program voltage) line to the source signal line 18.

This may apply to the other embodiments as shown in, for example, FIGS. 127-143, 293-297, 308-313, 338-345 and 349-354 in the present invention.

FIGS. 77 and 78 show the latching circuit 771 configured or formed to latch the pre-charge bit on the source driver circuit (IC) 14 (the circuit or IC for outputting the program current). However, the present invention is not limited thereto. For instance, it is also applicable to the source driver circuit or IC for outputting the program voltage.

It is possible to place or configure a pre-charge function, the latching circuit for latching a pre-charge signal or a pre-charge selection signal line on the source driver circuit (IC) 14 and thereby set the potential of the source signal line at a predetermined value before writing the program voltage to the source signal line 18 so as to improve writing stability.

In FIGS. 77 and 78, it was described that pre-charge signal lines (RPC, GPC, BPC) are rendered as one, and the latching circuit corresponding to it has two 1-bit stages. However, the present invention is not limited thereto. As shown in FIG. 75 for instance, four pre-charge signal lines are required in the case where the pre-charge signal is comprised of 4 bits. Therefore, it goes without saying that the latching circuit of the pre-charge signal requires 4 bits for the two stages. As shown in FIGS. 77, the latching circuit 771 is not limited to the two stages. It goes without saying that the latching circuit may be comprised of three or more stages. For instance, if comprised of four stages, the current signal to be written to the source signal line 18 can secure the time twice as much, which is desirable. It goes without saying that the pre-charge signal line does not need to be provided individually for the R, G, and B. It may be the signal line common to the RGB.

As described above, the source driver circuit (IC) 14 of the present invention has the circuit holding a determination bit for selecting whether or not to apply the pre-charge signal when writing the program current or the program voltage to the source signal line 18 and also has a signal input terminal for transmitting a signal held by the determination bit or an assumed signal.

It is also possible to change or vary the pre-charge voltage (synonymous with or similar to the program voltage) applied to the source signal line according to a lighting rate. For instance, the value of a selection signal D of FIG. 75 is changed against the lighting rate, and the electronic regulator 501 is controlled to change the pre-charge signal outputted from the terminal 155. As the current passing through the driving transistor 11a changes according to the lighting rate, the size of the optimum pre-charge voltage (synonymous with or similar to the program voltage) changes (especially in the case of performing the gradation display by the voltage driving). It is possible to control the electronic regulator 501 to have an optimum gradation display according to the lighting rate so as to implement the gradation display.

The embodiment changes the pre-charge voltage (synonymous with or similar to the program voltage) according to the lighting rate. However, the present invention is not limited thereto. It is also possible to change the pre-charge voltage (synonymous with or similar to the program voltage) according to the reference current ratio. It is because the current passing through the driving transistor 11a changes and the optimum pre-charge voltage (synonymous with or similar to the program voltage) (the voltage applied to the gate terminal voltage of the driving transistor 11a) changes according to the size of the reference current. It is also possible to change the pre-charge voltage (synonymous with or similar to the program voltage) according to the size of the current of the anode (cathode) terminal.

According to FIGS. 127 to 143, FIG. 293, FIG. 311, FIG. 312 and FIGS. 339 to 344, it was described that a judgment is made whether the pre-charge voltage (program voltage) is applied sequentially to each of the pixel lines. However, the present invention is not limited thereto. For instance, it is also possible, in the case of an interlaced driving, to apply the pre-charge voltage (synonymous with or similar to the program voltage) to odd-numbered pixel lines in the first field and apply the pre-charge voltage (synonymous with or similar to the program voltage) to even-numbered pixel lines the second field.

There is also an exemplified driving method of applying the pre-charge voltage (synonymous with or similar to the program voltage) to each pixel line in an arbitrary frame and applying no pre-charge voltage (synonymous with or similar to the program voltage) in the next frame. It is also possible to perform the driving to apply the pre-charge voltage (synonymous with or similar to the program voltage) randomly to each pixel line so as to apply the pre-charge voltage (synonymous with or similar to the program voltage) averagely to each pixel in multiple frames.

There is also an exemplified driving method of applying the pre-charge voltage (synonymous with or similar to the program voltage) only to specific low-gradation pixels. There is also an exemplified driving method of applying the pre-charge voltage (synonymous with or similar to the program voltage) only to specific high-gradation pixels. There is also an exemplified configuration of applying the pre-charge voltage (synonymous with or similar to the program voltage) only to specific middle-gradation pixels. There is also an exemplified configuration for applying the pre-charge voltage (synonymous with or similar to the program voltage) from the source signal line potential (image data) preceding by 1H or multiple Hs to the pixels in a specific gradation range.

This may apply to the other embodiments as shown in, for example, FIGS. 127-143, 293-297, 308-313, 338-345 and 349-354 in the present invention.

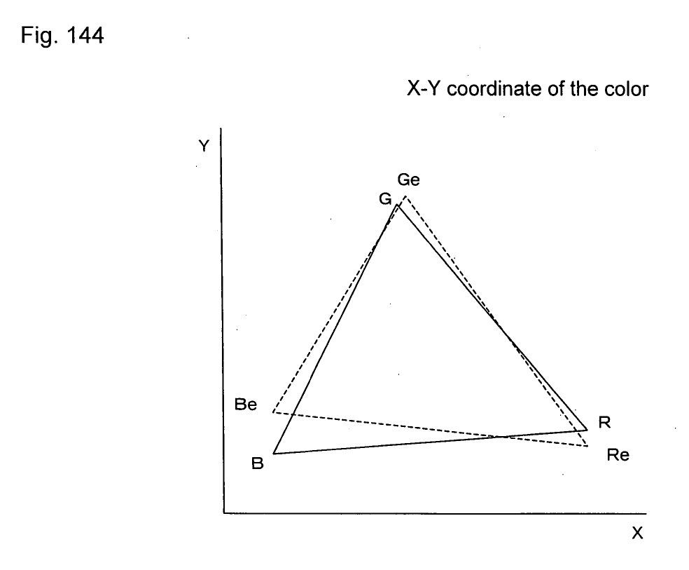

Furthermore, embodiments which use the EL display panel, EL display apparatus, or drive method according to the present invention will be described with reference to drawings. There is a problem that the EL display panel has a bad color of B and also a fact that it has a good color of R. For that reason, there are the cases where the display color is different from the original image when the image is displayed. As for the X-Y coordinate of the color of FIG. 144, the full line indicates a color range of NTSC. The dotted line indicates the color range of the organic EL. As there is a deviation between a color reproduction range of NTSC and a color reproduction range of the organic EL, there is a problem that, in an image display having a lot of green of trees in particular, leaves have a color of dead leaves.

A measure for solving this problem is the color management process. It performs color correction of the images by signal processing. A measure for improving the color of the images by a color filter 5861 is also exemplified (refer to FIG. 586).

To improve color purity of the EL display panel with the color filter 5861, the color filter 5861 should be placed, configured or formed on a light exit side of a display panel 71 as shown in FIG. 586. As shown in FIG. 360(a), the color filter 5861 may be placed or formed between a polarizing film 109 and the display panel 71. As for the color filter 5861, the color of B can be improved by using the one for filtering out a cyan color. As for the color filter 5861, an interference filter consisting of optical interference multilayer may be used in addition to a filter consisting of a resin. As shown in FIG. 586(b), the color filter 5861 may be formed or placed on or under the polarizing film (including a circularly-polarizing film) 109. It is also possible to add a light diffusion agent or a configuration for diffusing light to the color filter 5861 or the polarizing film 109 so as to improve a viewing angle and reduce color beat.

To implement color management (color correction process) circuit-wise, a change should be made to the output ratio of the unit transistor 154 of the RGB outputted from each unit transistor group 431. To suppress a phenomenon that the color of B is bad (while the color of R is good) and the leaves of the trees become dead in the organic EL, either the current of B should be increased or the current of R should be reduced. A measure for increasing the current of G is also effective. To be more specific, a color position of the display image is determined from the ratio among the R, G, and B currents of the display image so as to change the size of the output current of at least one of the R, G, and B (the color management process method of the present invention).

To adjust the output current of the unit transistor group 431c, the current Ic of FIG. 46 should be adjusted (by the RGB). Incidentally, it goes without saying that the above items, configurations, methods and apparatuses explained herein are applicable in the embodiments in the present invention.

The configuration for adjusting the current Ic is exemplified in FIG. 145. FIG. 145(a) has the configuration in which 8-bit data is converted to an analog signal by a DA circuit 661 and inputted to the operational amplifier 502a to change (adjust) the current Ic. The basic current size is set by the external or built-in resistor R1.

FIG. 145(b) has the configuration in which 8-bit data is converted to an analog signal by a DA circuit 661 to change (adjust) the current Ic. The basic current size is set by the external or built-in resistor R1. However, FIG. 145(b) has the configuration in which the change in the current Ic against the output voltage of the DA circuit 661 is nonlinear.

FIG. 145(c) has the configuration in which 8-bit data is converted to an analog signal by a DA circuit 661 to change (adjust) the current Ic via the transistor 157b. The basic current size is set by the external or built-in resistor R1. However, FIG. 145(c) has the configuration in which the change in the current Ic against the output voltage of the DA circuit 661 is nonlinear.

FIG. 146 shows a circuit configuration using the electric voltage volume 501. FIG. 60 shows a configuration where the output of DA circuit 661 is connected to the terminal voltage Vs of the electric volume circuit 501. Other configurations will not be explained here because they are similar to or even the same to the configuration as shown in FIG. 60, 50 and 46, or the like. To be more specific, the current Ic is switchable by the electronic regulator 501 and also adjustable by the output of the DA circuit 661 of the color management process.

It goes without saying that the configurations of FIG. 145 and 146 may be combined. It also goes without saying that the color management process may be performed by controlling the electronic regulator 501 in FIG. 146.

FIG. 147 is a deformation example of FIG. 146. It has the configuration in which the voltage Vc can be directly inputted to an input terminal c of the operational amplifier 502a. When inputting Vc, the electronic regulator 501 is controlled to have no switch S selected and to have all switches become open. The current Ic is easily controllable or adjustable by applying the voltage Vc from outside the IC 14.

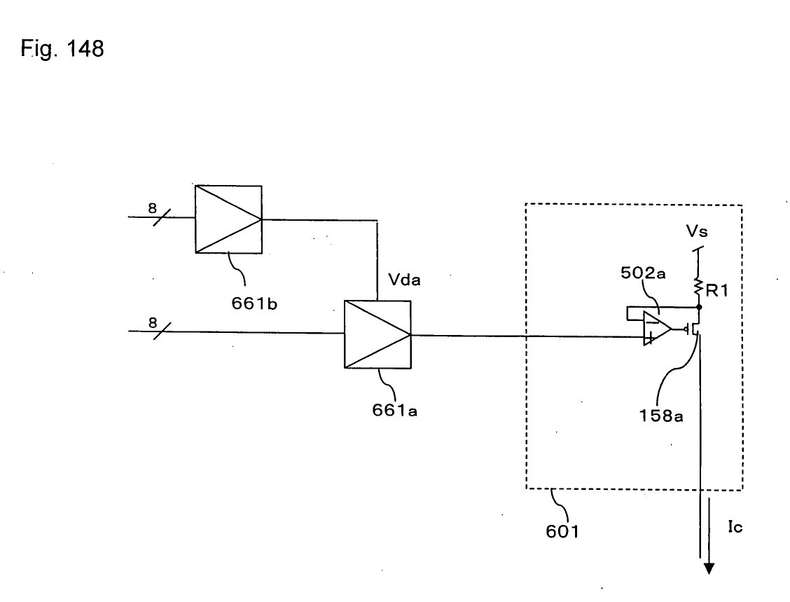

In FIG. 148, a power supply voltage Vda of a DA circuit 661a is changed with a DA circuit 661b so as to change the input terminal voltage of the operational amplifier 502a. The output current Ic is linearly changed by the input terminal voltage.

In FIG. 148, the output voltage of the DA circuit 661a is linearly changed by the 8-bit digital data, and is linearly changed further by the output voltage of the DA circuit 661b. FIG. 148 has a desirable circuit configuration in which width of the change in the current Ic is large and the change is linear.

The color management process is controlled by the current of each of the RGB. The current of the RGB is representable by the lighting rate (the duty ratio is 1/1. When the duty ratio is 1/1, the lighting rate is calculable from the sum total and maximum value of the image data. When performing the color management process, the lighting rate is acquired individually for the R, G and B. To be more specific, the lighting rate of R, lighting rate of G and lighting rate of B are acquired (it means that the consumption current of R, consumption current of G and consumption current of B are acquired), and the color management process is performed in a predetermined range of ratio and size. It is because the color management process is unnecessary in the state of having a lot of white display on the screen because a white balance is kept.

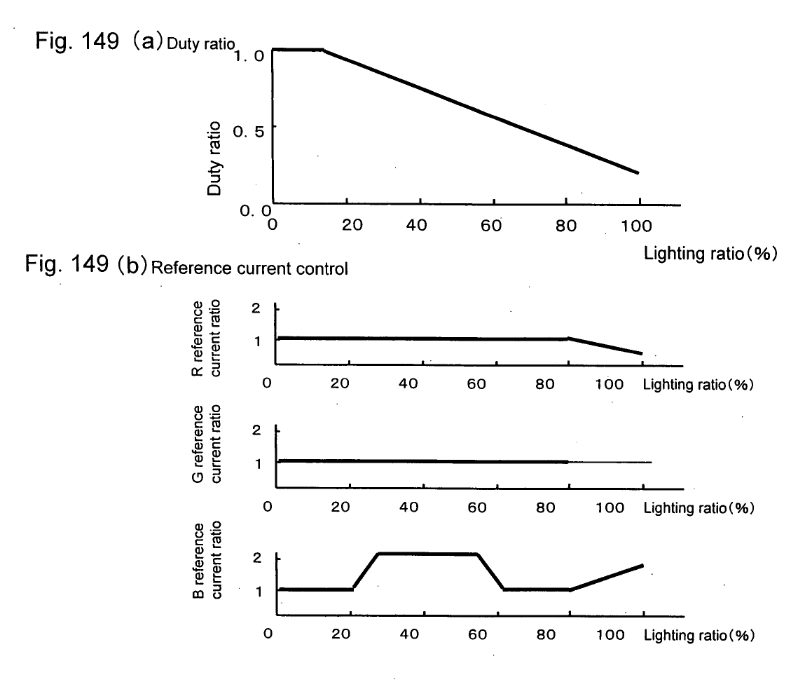

FIGS. 149(a) and (b) are schematic diagrams of the color management process method. As previously described, the duty ratio control is performed to average the consumption current of the EL display panel. The color management process is performed by adjusting the reference current Ic. In FIGS. 149(a) and (b), a reference current of R Icr is reduced and a reference current of B Icb is increased in the range of the high lighting rate. The reference current of B Icb is also increased in the range of an intermediate level (30 to 60 percent) of the lighting rate to make an adjustment. The color management process of the EL display apparatus can be implemented well by the above process.

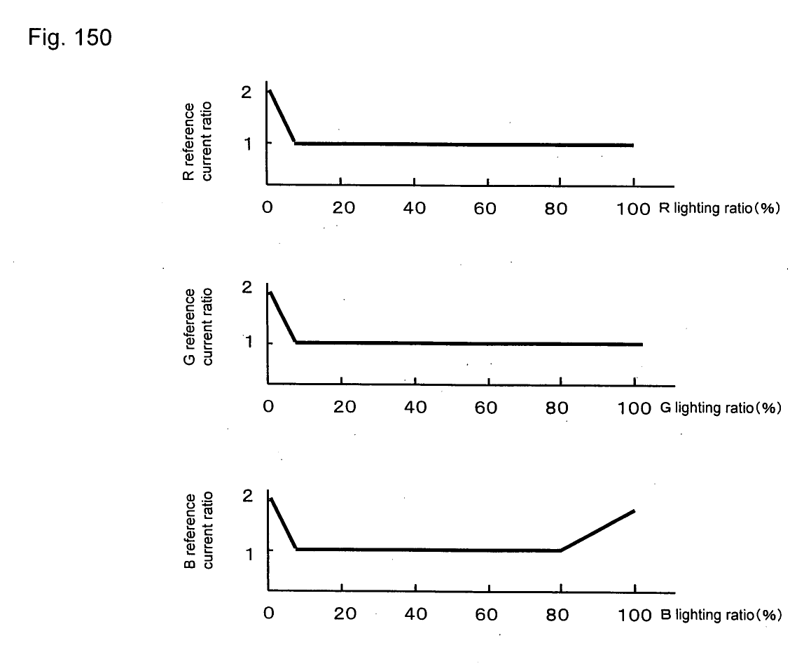

In FIG. 150, the reference current Ic of the RGB is increased in the area of the low lighting rate. This is intended to increase a dynamic range of the image at the low lighting rate. It is the color management process in that the reference current of B Icb is increased in the area in which the lighting rate of B is high. As described above, the present invention can implement both the dynamic process of the image and color management process by controlling the reference current.

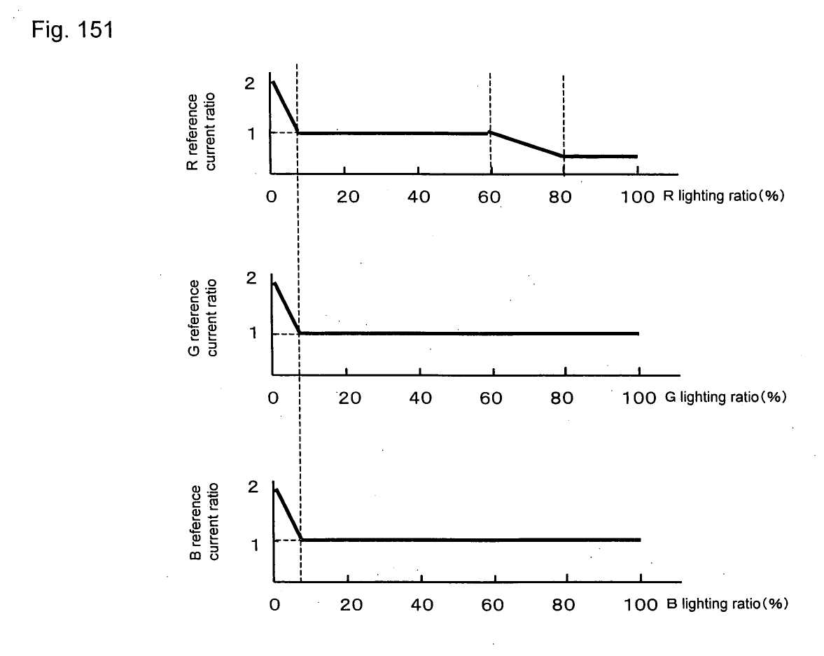

FIG. 151 is a method of controlling the reference current of R Icr at multiple levels. As described above, the present invention can implement the color management process by adjusting the reference current freely.

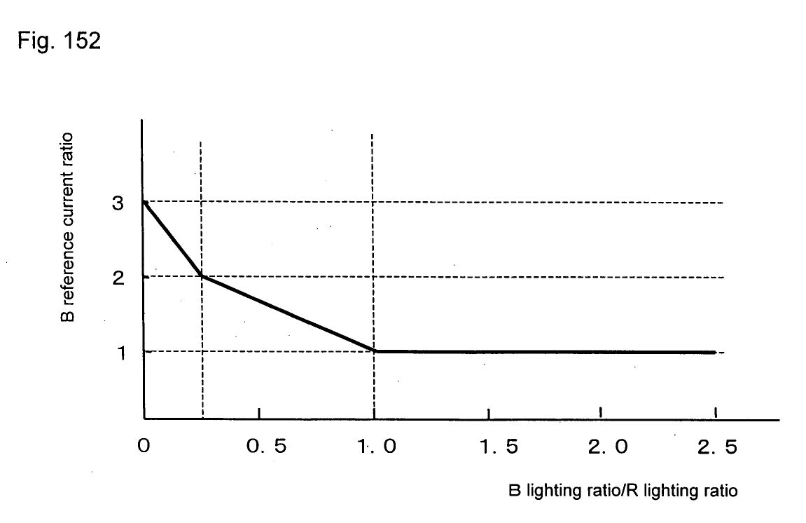

FIG. 152 is a method of controlling the reference current based on the lighting rate of the RGB. However, the color management process of the EL display panel may also be controlled by the ratio between the currents of R and B (Icr and Icb). FIG. 152 is a schematic diagram of the embodiment. It indicates lighting rate B/lighting rate R (consumption current B/consumption current R) instead of the lighting rate of the horizontal axis of FIGS. 149(a) and (b). When the lighting rate B/lighting rate R (consumption current B/consumption current R) becomes a certain value or more, the reference current of B Icr is changed.

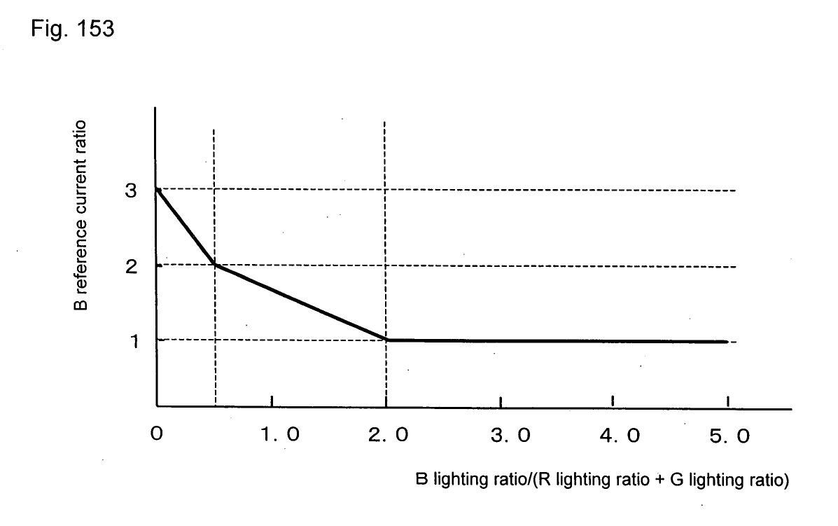

Similarly, FIG. 152 indicates lighting rate B/lighting rate R (consumption current B/consumption current R) instead of the lighting rate of the horizontal axis of FIGS. 149(a) and (b). Also in FIG. 153, when the lighting rate B/(lighting rate R+lighting rate G) (consumption current B/(consumption current R+lighting rate G) becomes a certain value or more, the reference current of B Icr is changed.

The configurations of FIGS. 145 to 148 are the configurations for adjusting or controlling the reference current Ic. It is possible, by changing the current Ic, to change the output current of the unit transistor group 431c. Therefore, it goes without saying that the configurations can be used not only for the color management process but also for gradation control, output current of the unit transistor group 431c or a white balance adjustment circuit.

The embodiments described that the color management process is performed by adjusting the reference current Ic. However, it is not limited thereto. It is possible to adjust the luminance of the RGB individually by adjusting the duty ratio or changing, controlling or adjusting the ratio of a nondisplay region 51 of each of the RGB. Therefore, it goes without saying that the color management process may be implemented by using the configurations or methods.

The embodiments mainly described the methods or configurations (apparatuses) for implementing the color management in view of the differences between the colors of the EL element 15 of the RGB and the colors of the NTSC. However, the color management is not only required for the embodiments but also required for the luminous efficiency of the EL element 15.

FIG. 321 is a graph showing the relation between an EL current and the luminance of the EL element of the RGB. As shown in FIG. 321, G has the relation in which, if the EL current becomes large, the luminance increases proportionally. As for R, however, the increase in the luminance becomes moderate at the EL current I0 or more (not proportional=reduction in luminous efficiency) As for B, furthermore, the increase in the luminance becomes moderate at the EL current I1 or more (not proportional=reduction in luminous efficiency).

Because of the above, the luminance of B is relatively reduced at the EL current I1 or more so that the white balance can no longer be kept. Furthermore, the luminance of R at I0 or more is also relatively reduced so that the white balance can no longer be kept. To solve these problems and maintain the white balance against the change in the EL current, it is necessary to render the relation between the EL current and the gradation nonlinear as indicated by the dotted lines (R′, B′) in FIG. 322. In FIG. 322, the EL current of R is increased at gradation K2 or more (R′). Furthermore, the. EL current of R is increased at gradation K1 or more (B′).

The above control can be easily implemented by changing the reference current of the RGB according to the gradation. For instance, the reference current may be changed against R as shown in FIG. 323. To be more specific, the reference current ratio of R is increased from 1 in inverse proportion to the efficiency of the EL element of R at gradation K2 or more. Furthermore, the reference current may be changed against B as shown in FIG. 323. To be more specific, the reference current ratio of B is increased from 1 in inverse proportion to the efficiency of the EL element of B at gradation K1 or more.

As with the organic EL display panel, a self-luminous device has the problem of image sticking on displaying a fixed pattern. Sticking means a phenomenon that a material of the organic EL deteriorates due to light emission and emission intensity decreases. To prevent the sticking, it is better to move a display position of the display image temporally on displaying the fixed pattern. For instance, the screen position is moved at one-minute intervals. It should desirably be moved by one or two pixels or so. If moved by three or more pixels, it is visually recognized that the display image is moved.

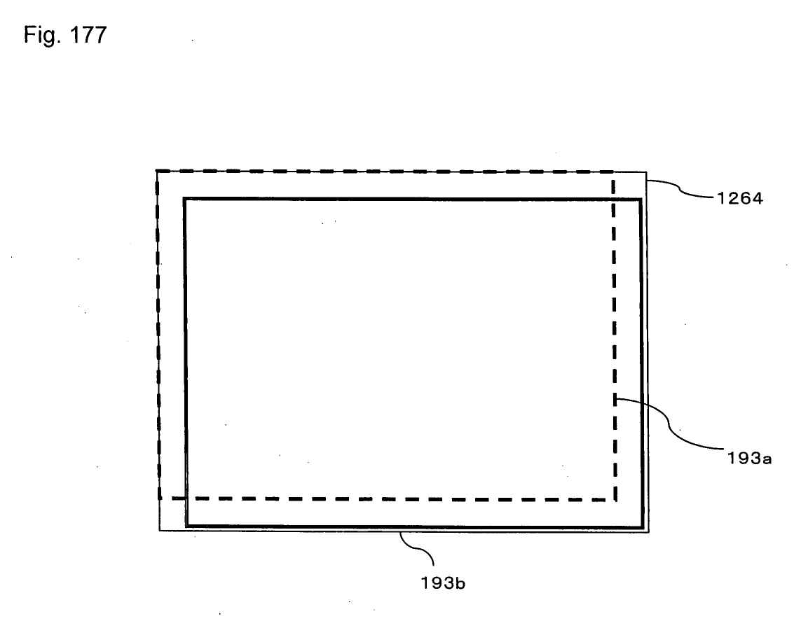

Movement of a display image 1264 means to move it to a position 193a or a position 193b as shown in FIG. 177. It is moved by one or two pixels vertically or horizontally.

Timing of movement is determined by the lighting rate. Screen movement control is performed when the lighting rate changes suddenly. The state of the lighting rate changing suddenly may include the change of the screen from a dark state to a bright state (from a night scene to a daytime sea scene, for instance), change of the screen from a bright state to a dark state and change from a drama scene to a commercial scene.

The state of the lighting rate changing suddenly is the state of the scene (screen) changing suddenly. As the state of the screen changes suddenly, a change in the display position of the image, if any, will not be visually recognized. It is because the contents of the image (display state of the image) completely change in most cases. It is possible to change the display position of the image by using the sudden change in the lighting rate so as to suppress the sticking of the fixed pattern.

The sudden change in the lighting rate is the case where a change changes to twice or equal to or more than ½. For instance, if the lighting rate at a certain time is 10 percent, it is the state in which the lighting rate changes to 20 percent or more or it changes to below 5 percent. In the case where the lighting rate changes as above, the display position of the screen is changed. A change in the display position of the screen is made by delaying a start pulse in a horizontal or vertical direction by 1 clock or 2 clocks. This operation can be implemented by changing a comparison value of the counter.

The time when the lighting rate changes suddenly is synonymous with the time when the anode current or the cathode current changes suddenly. Therefore, the sudden change in the lighting rate is the case where the anode current or the cathode current changes to twice or more or below ½. In this case, the screen position is changed. For instance, if the anode current or the cathode current is 50 mA, the screen position is changed in the case where the anode current or the cathode current changes to 100 mA or more or below 25 mA.

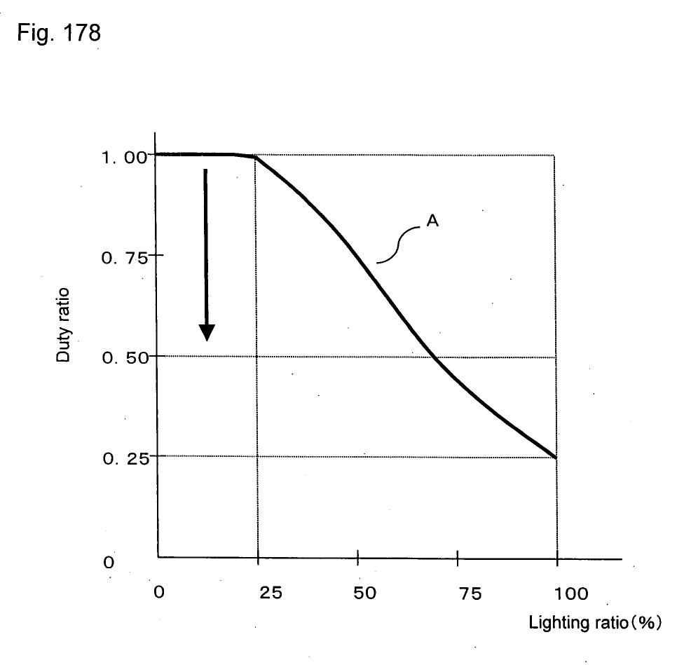

According to the present invention, the lighting rate, anode current or cathode current works in conjunction with the duty ratio. Therefore, the sudden change in the lighting rate is synonymous with the state in which the duty ratio changes to twice or more or below ½. To be more specific, the screen position is changed in conjunction with the duty ratio in the case where the duty ratio changes or is changed. For instance, in the case where the duty ratio is changed to 0.5 as indicated by the arrow at the lighting rate of 1 to 25 percent (duty ratio 1.0) as shown in FIG. 178, the display position of the screen is changed.

The embodiment described that the display position of the screen is changed when the lighting rate changes. However, the present invention is not limited thereto. It is also possible, for instance, to change the display position of the screen from a previous display position when the display panel is put in the lit-up state (when the power is turned on, for instance). To be more specific, the display position of the screen is changed each time the power is turned on or off.

To prevent burn-in, it is effective to gradate edges of the image. To be more specific, the edges of the image are gradated by integrating (low-pass filtering) the image data (a process opposite to a derivative). In particular, the image is displayed in the black display when the lighting rate is low. And when the lighting rate is low, the duty ratio is reduced and so the luminance of the pixel is high. Therefore, the sticking becomes easier. To be more specific, the process of gradating the edges of the image (integration process) is performed when the lighting rate is low. To be more specific, the present invention changes the integration process of the image according to the lighting rate. The integration process is increased when the lighting rate is low, and is decreased (a normal display is performed) when the lighting rate is high.

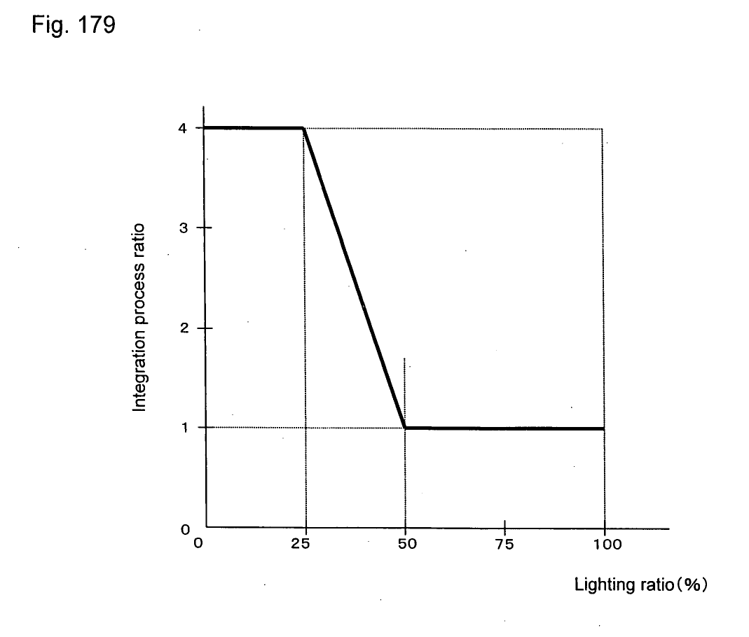

The embodiment is shown in FIG. 179. The integration process at 1 is the state of performing no integration process. As this rate becomes larger, the integration process becomes stronger and the pixel edges get gradated. In FIG. 179, it is the normal display at the lighting rate of 50 percent or more, and is changed to an integration process ratio of 4 to 1 at the lighting rate of 25 to 50 percent. It is fixed to the integration process ratio of 4 at the lighting rate of below 25 percent. It is possible to alleviate the burn-in of the pixel edges by exerting control as above.

According to the embodiment of the present invention, the lighting rate is basically synonymous with or similar to the size of the anode current or the cathode current. Therefore, it is also possible to change the integration process ratio according to the size of the anode current or the cathode current. The anode current or the cathode current is in conjunction with the duty ratio. Therefore, it is also possible to change the integration process ratio in conjunction with the duty ratio.

The embodiment described that the display position of the screen is changed when the lighting rate changes. However, the present invention is not limited thereto. It is also possible, for instance, to change the display position of the screen from a previous display position when the display panel is put in the lit-up state (when the power is turned on, for instance). To be more specific, the display position of the screen is changed each time the power is turned on or off.

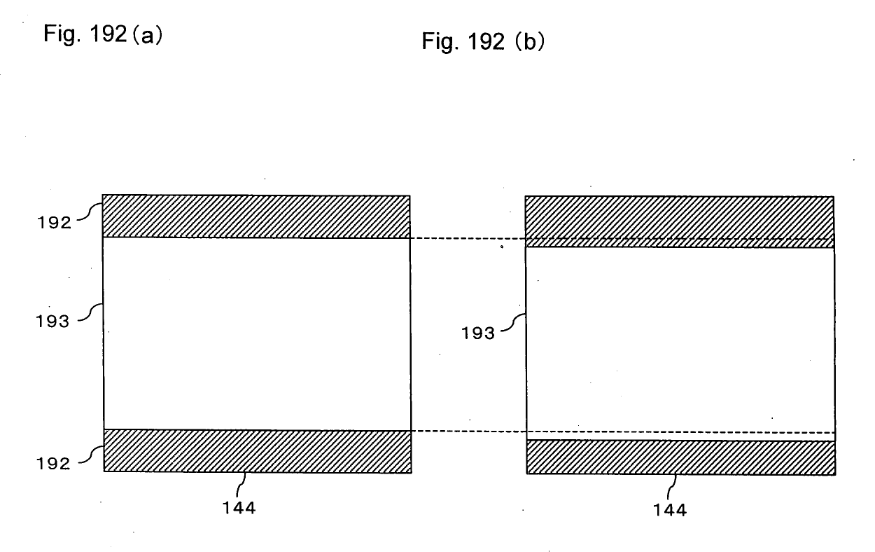

As shown in FIG. 192, in the case of performing a wide display such as 16:9 on the screen of 4:3, it may be displaced by one or two pixel lines as shown in FIGS. 192(a) and (b). This control should be implemented in synchronization with the lighting rate control, reference current control, duty ratio control, anode (cathode) current control and on and off control.

This specification described that the reference current is changed. To change the reference current is to change the program current Iw passing through the source signal line. Therefore, it goes without saying that to vary, control or adjust the reference current is, in other words, to vary, control or adjust the program current Iw passing through the source signal line 18.

As a characteristic of the present invention, it is possible, by changing the reference current, to change, adjust, vary or control the current outputted from the terminal 155 of the source driver circuit (IC) 14 proportionally, at a fixed rate or in a state of maintaining a predetermined relation.

According to the driving method of the present invention, the program current Iw matches with the current Ie passing through the EL element 15. Therefore, it goes without saying that to vary, control or adjust the reference current is, in other words, to vary, control or adjust the current Ie (Iw) passing through the driving transistor or EL element 15. In the pixel configurations of FIGS. 31 and 36, however, the current Ie passing through the EL element 15 and Iw do not match. However, it goes without saying that to vary, control or adjust the reference current is to vary, control or adjust the program current Iw passing through the source signal line 18, in other words, to vary, control or adjust the current Ie passing through the EL element 15 almost proportionally.

As described in FIGS. 128, 129 and 130, to change the reference current is to change the potential of the source signal line 18. For instance, if the reference current is increased, the program current Iw becomes proportionally (relatively) larger so as to reduce the potential of the source signal line 18 (when the driving transistor is P-channel). Inversely, if the reference current is reduced, the program current Iw becomes proportionally (relatively) smaller so as to increase the potential of the source signal line 18 (when the driving transistor is P-channel) Therefore, to vary, control or adjust the reference current is synonymous with being able to change, adjust, vary or control the potential of the source signal line 18 proportionally, at a fixed rate or in a state of maintaining a predetermined relation.

According to the driving method of the present invention described in FIGS. 271 to 276, multiple pixel lines are simultaneously selected and the program current Iw is applied dividedly (averagely) to the selected pixel lines. For instance, if four pixel lines are simultaneously selected and the program current is Iw, a program current Ip written to one pixel line is ideally Iw/4. Furthermore, if two pixel lines are simultaneously selected and the program current is Iw, a program current Ip written to one pixel line is ideally Iw/2.

If driven as above, the program current Ip divided by the selected number of pixels is written to one pixel line. Therefore, the display luminance of the pixel 16 is one over the number of the divided pixel lines. Therefore, the display luminance becomes dark. To prevent this, the reference current should be increased. For instance, in the case where two pixel lines are simultaneously selected as in FIG. 171, the reference current is doubled so as not to reduce the luminance. To be more specific, the driving method of the present invention performs the driving by increasing the reference current by multiplying it by the number of the selected pixel lines.

The reference current to be increased does not need to be completely multiplied by the number of the selected pixel lines. According to an evaluation result, if the number of the selected pixel lines is N and magnification of the reference current to be increased is C, N-C should be controlled to be 0.8 to 1.2. If in this range, no flicker occurs and good image display can be implemented.

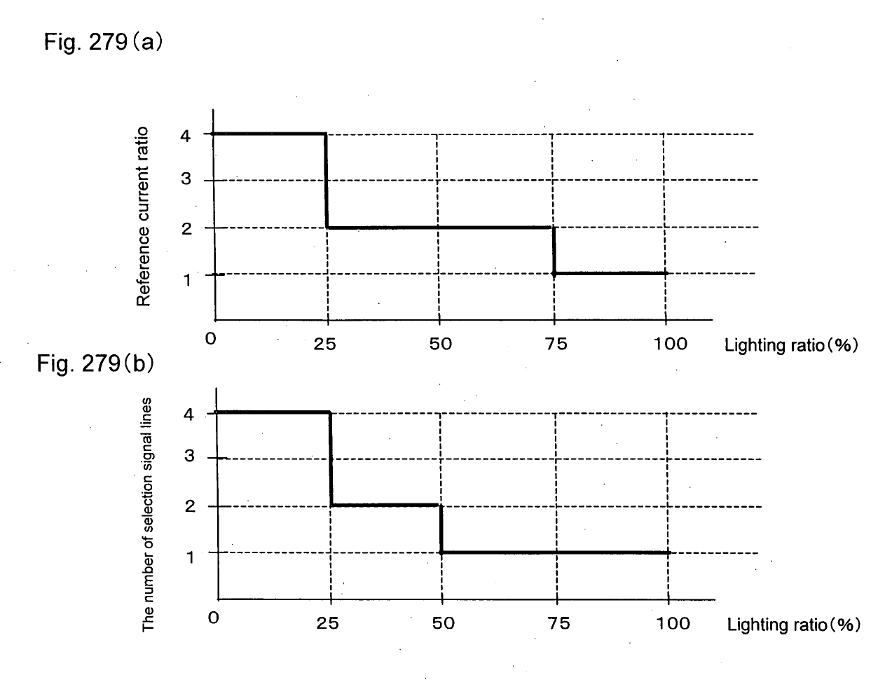

The present invention is not limited to the embodiments. The number of the selected pixel lines (the number of the selected signal lines: vertical axes of FIGS. 277(a) and (b) to FIGS. 279(a) and (b)) may be changed according to the lighting rate. In FIGS. 277(a) and (b), the number of the selected signal lines (the number of the pixel lines) is two pixel lines at the lighting rate of below 25 percent (the driving method of FIGS. 271). And the number of the selected signal lines (the number of the pixel lines) is one pixel line at the lighting rate of 25 percent or more (the driving method of FIGS. 23). At the lighting rate of below 25 percent, the reference current (reference current ratio) is also doubled (against the range of the lighting rate of 25 percent or more) so as not to reduce the luminance of the pixel 16.

As described above, the number of the selected pixel lines is changed and the reference current ratio is also changed according to the lighting rate because there are a lot of black display areas and crosstalk is apt to be conspicuous in the low lighting rate region of the screen 144. As the program current Iw is increased, the crosstalk is resolved accordingly. The program current Iw is proportional to the size of the reference current Ic. Therefore, if the reference current Ic (reference current ratio) is increased, the program current Iw is increased and the crosstalk is resolved. If the program current Iw is increased, however, the luminance of the pixel also becomes higher in proportion to it. To resolve this, the driving method described in FIGS. 271 is implemented to increase the number of the selected lines, and the program current Iw is rendered as Ip of one over the number of the selected pixel lines so as to prevent the luminance from becoming higher.

In FIGS. 277 (a) and (b), the number of the selected signal lines (the number of the pixel lines) is two pixel lines and the reference current ratio is double at the lighting rate of below 25 percent. Therefore, the luminance of the pixel 16 is the same as that in the case where the number of the selected signal lines (the number of the pixel lines) is one pixel line and the reference current ratio is one time. At the lighting rate of 25 percent or more, it is the same driving method as FIGS. 23 in which the number of the selected signal lines (the number of the pixel lines) is one pixel line and the reference current (reference current ratio) is one time.

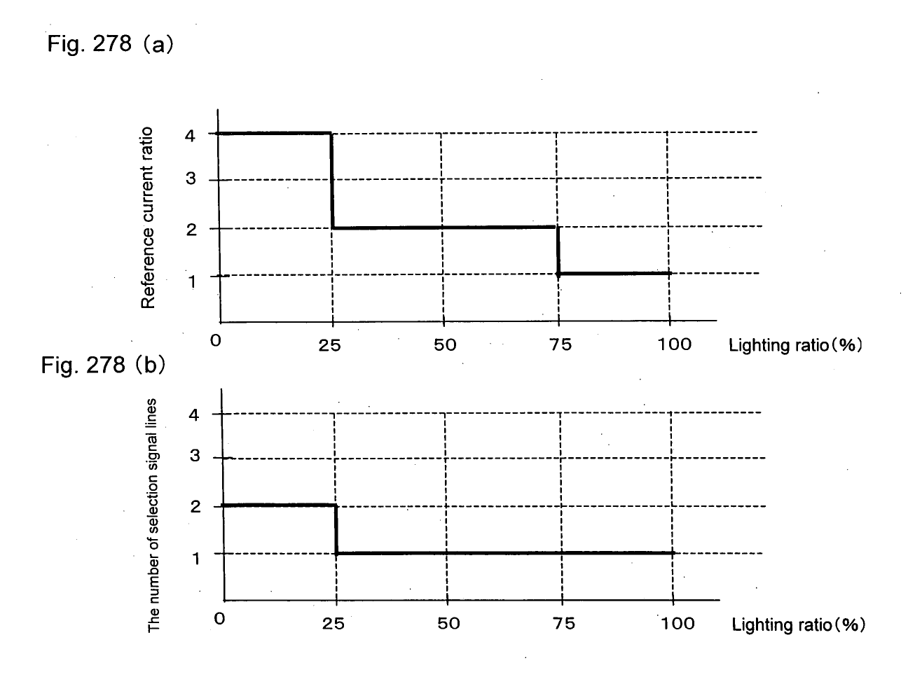

The present invention is not limited to this. It may be performed as shown in FIGS. 278(a) and (b). In FIGS. 278(a) and (b), the number of the selected signal lines (the number of the pixel lines) is two pixel lines and the reference current ratio is four times at the lighting rate of below 25 percent. Therefore, the luminance of the pixel 16 is twice higher than before. However, the reference current ratio is four times, and so occurrence of the crosstalk is completely preventable. To keep the luminance from becoming double, the duty ratio should be ½ in the region of the lighting rate of below 25 percent. To be more specific, the number of the selected signal lines (the number of the pixel lines), reference current ratio and duty ratio should work in conjunction.

In FIGS. 278(a) and (b), the number of the selected signal lines (the number of the pixel lines) is one pixel line and the reference current ratio is twice at the lighting rate of from 25 to 75 percent. Therefore, the luminance of the pixel 16 is twice higher than before. To keep the luminance from becoming double, the duty ratio should be ½. Similarly, the number of the selected signal lines (the number of the pixel lines) is one pixel line and the reference current ratio is one time at the lighting rate of 75 percent or more. Therefore, the luminance of the pixel 16 is the same as before if the duty ratio is 1/1. In this lighting rate region, it is possible to suppress the luminance of the screen 144 and the power consumption of the panel by setting the duty ratio below 1/1.

FIGS. 279(a) and (b) is other embodiments according to the present invention. In FIGS. 279(a) and (b), the number of the selected signal lines (the number of the pixel lines) is four pixel lines and the reference current ratio is four times at the lighting rate of below 25 percent. Therefore, the luminance of the pixel 16 is the same as before. The reference current ratio is four times, and so occurrence of the crosstalk is completely preventable. The number of the selected signal lines (the number of the pixel lines) is two pixel lines and the reference current ratio is twice at the lighting rate of from 25 to 50 percent. Therefore, the luminance of the pixel 16 is the same as before. The number of the selected signal lines (the number of the pixel lines) is one pixel line and the reference current ratio is twice at the lighting rate of from 50 to 75 percent. Therefore, the luminance of the pixel 16 is twice higher than before. The number of the selected signal lines (the number of the pixel lines) is one pixel line and the reference current ratio is one time at the lighting rate of 75 percent or more. Therefore, the luminance of the pixel 16 is the same as before.

As described in FIGS. 277 to 279, in the case of doubling the number of the selected signal lines for instance, the reference current ratio should be doubled. To be more specific, when the number of the selected signal lines is rendered N times larger, the reference current ratio is rendered N times larger so as to keep the display luminance constant theoretically. In reality, however, there are the cases where a punch-through voltage state from the gate signal lines 12a to the driving transistor 11a changes and a little change in the luminance occurs when changing the number of the selected signal lines. If the change in the luminance occurs, it is recognized as the flicker.

As for this problem, a change in the number of the selected signal lines is made on a sudden change in the lighting rate. The sudden change in the lighting rate is made, for instance, when the scene on the screen changes or the channel is switched. To be more precise, when a change of 100 percent or more is made to the lighting rate of a certain screen (scene), the number of the selected signal lines is changed and the reference current ratio works in conjunction therewith simultaneously or with a certain delay or advance. If the lighting rate is 10 percent for instance, the number of the selected signal lines is changed when the lighting rate changes to 20 percent or 5 percent, and the reference current ratio works in conjunction therewith simultaneously or with a certain delay or advance.

As described above, the present invention is characterized by, at the low lighting rate (the screen having a lot of low gradation display) in particular, increasing the number of the selected signal lines, increasing the reference current and speeding up the charge and discharge of the parasitic capacitance in the source signal line 18 to resolve the shortage of the writing. The number of the selected signal lines is changed when the lighting rate changes.

As described above, the driving method of the present invention exerts control by the number of the selected signal lines (the number of the pixel lines), reference current ratio and duty ratio or a combination thereof so as to prevent the occurrence of the crosstalk.

It is described above that the reference current is changed based on the lighting rate. It means to change the program current Iw passing through the source signal line and also vary, control or adjust the program current Iw passing through the source signal line 18 based on the lighting rate. It also means to change, adjust, vary or control the current outputted from the terminal 155 of the source driver circuit (IC) 14 proportionally, at a fixed rate or in a state of maintaining a predetermined relation. It also means to change, adjust, vary or control the potential of the source signal line 18 or the gate terminal potential of the driving transistor based on the lighting rate or the data sum proportionally, at a fixed rate or in a state of maintaining a predetermined relation.

It goes without saying that to be based on the lighting rate is, in other words, to be based on the data sum on the video signals. It is because, in the case of the current driving in particular, the size of the video signal is in proportion to the current passing through the pixel 16. And the lighting rate is in proportion to or relative to the current passing through the anode terminal (cathode terminal). Therefore, it goes without saying that to be based on the lighting rate is, in other words, to be based on the size of the current passing through the anode terminal (cathode terminal) It is also possible, as a matter of course, to replace it by the current passing through the EL element 15.

The lighting rate does not need to be a continuous amount. For instance, it is possible, with a lighting rate 1 at a first anode current and a lighting rate 2 at a second anode current, to exert control differently between the case of the lighting rate 1 and the case of the lighting rate 2. To be more specific, the control by the lighting rate of the present invention is to make a change or exert control in multiple lighting rate states.

According to the present invention, a change is made to the first lighting rate (may be the anode current of the anode terminal or sum total of the data) or lighting rate range (may be the anode current range of the anode terminal or sum total of the data) as the first FRC, lighting rate, current passing through the anode terminal (cathode terminal), reference current, duty ratio or panel temperature or combinations thereof.

Furthermore, a change is made to the second lighting rate (may be the anode current of the anode terminal or sum total of the data) or lighting rate range (may be the anode current range of the anode terminal or sum total of the data) as the second FRC, lighting rate, current passing through the anode terminal (cathode terminal), reference current, duty ratio or panel temperature or combinations thereof. Or, a change is made according to the lighting rate (may be the anode current of the anode terminal or sum total of the data) or lighting rate range (may be the anode current range of the anode terminal or sum total of the data), the FRC, lighting rate, current passing through the anode terminal (cathode terminal), reference current, duty ratio or panel temperature or combinations thereof. This may be applicable to other embodiments in the present invention.

In FIG. 375, a capacitor signal line 3751 is operated to control the gate terminal potential of the driving transistor 11a so as to implement a good black display. It is possible to control the black display by the lighting rate (it may be the anode current of the anode terminal or sum total of the data). When the lighting rate (It may be the anode current of the anode terminal.

It may also be the sum total of the data) is high, when the lighting rate (It may be the anode current of the anode terminal. It may also be the sum total of the data) is high, the white display portion occupies most of the image. It is not necessary to render the black display good because halation arises. In the case where the lighting rate is low, the image of the black display portion occupies most of it. Therefore, it is necessary to implement the good black display. However, increasing the punch-through voltage and a potential shift amount of the gate terminal potential of the driving transistor 11a causes a margin of driving voltage to rise so as to consequently increase the load of the EL element 15.

To solve the problems, the potential shift amount of the capacitor signal line 3751 is changed according to the lighting rate as shown in FIG. 379. If the potential shift amount of the capacitor signal line 3751 is increased, the potential shift amount of the gate terminal of the driving transistor 11a increases. The following embodiment changes the potential shift of the capacitor signal line 3751. However, the present invention is not limited thereto. The operation (control method and so on) of the present invention is to shift the gate terminal potential of the driving transistor la correspondingly to the lighting rate. It also increases the potential shift amount (operates (controls) so as to make it difficult to pass the current through the driving transistor 11a) when the lighting rate is low.

At the low lighting rate, it increases the potential shift amount of the capacitor signal line 3751. It is possible, by increasing the potential shift amount, to increase the potential shift amount of the gate terminal of the driving transistor 11a so as to implement the good black display. The potential shift amount is kept constant in the range of the lighting rate of 25 to 50 percent. This range of the lighting rate often appears in the image display, and the flicker occurs if it is changed according to the lighting rate.

The change in the potential shift according to the lighting rate is implemented with a delay (slowly). At the high lighting rate, it reduces the potential shift amount of the capacitor signal line 3751. It is possible, by reducing the potential shift amount, to reduce the load of the EL element 15 so as to realize longer life.

The current driving method has the problem that the program current becomes small and the shortage of writing occurs in the low gradation region. The present invention implements the pre-charge driving, voltage+current driving and reference current control as countermeasures against this problem.

The cause of occurrence of the shortage of writing in the current driving is mainly influence of the parasitic capacitance Cs of the source signal line 18 as shown in FIGS. 380. The parasitic capacitance Cs is generated at the intersection of the gate signal line 17 and the source signal line 18 and so on.

To facilitate the description, the following description will be given as to the case where the driving transistor 11a of the pixel 16 is the P-channel transistor, and the current program is implemented by the absorption current (current absorbed in the source driver circuit (IC) 14). The relation is reversed in the case where the driving transistor 11a of the pixel 16 is the N-channel transistor or the current program is implemented to the driving transistor 11a by the discharge current (current discharged from the source driver circuit (IC) 14). To change it or reread it in the reversed relation is easy to those skilled in the art, and so the description thereof will be omitted.

The driving transistor 11a of the pixel 16 is not limited to the P-channel. Furthermore, although the pixel configuration is explained referring to FIG. 1, any pixel configurations of the current drive may apply to as shown in FIG. 12 or the like. Needless to say, this may apply to the present invention.

As shown in FIG. 380(a), when changing from the black display (low gradation display) to the white display (high gradation display), the source driver circuit (IC) 14 is driven by the sink current as a main operation. The source driver circuit (IC) 14 absorbs the charge of the parasitic capacitance Cs with a program current Id1 (Iw). The charge of the parasitic capacitance Cs is discharged by absorbing the current, and the potential of the source signal line 18 is reduced. Therefore, the gate terminal potential of the driving transistor 11a of the pixel 16 is reduced, and the current program is implemented to pass the program current Iw.

When changing from the white display (high gradation display) to the black display (low gradation display), the operation of the driving transistor 11a of the pixel 16 is main. The source driver circuit (IC) 14 outputs the current of the black display, which is too minute to operate effectively. The driving transistor 11a operates, and charges the parasitic capacitance Cs so as to match with the potential of a program current Id2 (Iw). The potential of the source signal line 18 is increased by charging the parasitic capacitance Cs. Therefore, the gate terminal potential of the driving transistor 11a of the pixel 16 is increased, and the current program is implemented to pass the program current Iw.

As for the driving of FIG. 380 (a), however, the current Id1 is small in the low gradation region and it is a constant-current operation so that it takes a very long time to discharge the charge of the parasitic capacitance Cs. As the time until reaching a white luminance is especially long, the luminance of the upper hem in the white window display is lower than the predetermined luminance. For that reason, it is visually conspicuous. In FIG. 380(b), the driving transistor 11a performs a nonlinear operation and so a current Id2 is relatively large. For that reason, receiving time of Cs is relatively short. As the time until reaching a black luminance is especially short, the luminance of the lower hem in the white window display is apt to decrease so that it is not visually conspicuous.

To solve the problem of the shortage of writing of the program current, the voltage+current driving, punch-through voltage driving, duty driving and pre-charge driving are performed. However, there are the cases where it becomes difficult, if the panel is large, to implement the black to white display of FIG. 380(a) just by this method. As for the countermeasure against this, the present invention increases the program current from the source driver circuit (IC) 14 in a first half of 1H. The normal program current Iw is outputted in a second half. To be more specific, when under predetermined conditions, the current larger than the predetermined program current is passed through the source signal line 18 at the beginning of 1H, and the normal program current is passed through the source signal line 18 in the second half. Hereunder, this embodiment will be described.

The driving method (driving apparatus or system) described below is called the overcurrent (pre-charge current or discharge current) driving. It goes without saying that the overcurrent (pre-charge current or discharge current) driving can be combined with the other driving systems or apparatuses (voltage+current driving, punch-through voltage driving, duty driving and pre-charge driving) of the present invention. It also goes without saying that the overcurrent driving can be combined with the other embodiments, such as a differential signal IF of FIG. 81.

FIG. 381 is a schematic diagram of the source driver circuit (IC) 14 implementing the overcurrent (pre-charge current or discharge current) driving system of the present invention. Its basic configuration is that in FIGS. 15, 58 and 59. To facilitate illustration, a current circuit with one unit transistor 154 is referred to as a transistor group 164a which is indicated as ‘1.’ Thereafter, a current circuit with two unit transistors 154 is referred to as a transistor group 164b which is indicated as ‘2’ likewise. A current circuit with four unit transistors 154 is referred to as a transistor group 164c which is indicated as ‘4.’ A current circuit with eight unit transistors 154 is referred to as a transistor group 164d which is indicated as ‘8.’ It follows likewise thereafter. To facilitate the description, each of the RGB is 6 bits.

In the configuration of FIG. 381, the transistor group for passing the program current of the overcurrent (pre-charge current or discharge current) is indicated as a transistor group 164f. To be more specific, it is possible, by controlling on and off of a switch D5 of the highest-order bit of the gradation data, to pass the overcurrent (pre-charge current or discharge current) through the source signal line 18. It is possible, by passing the overcurrent (pre-charge current or discharge current), to discharge the charge of the parasitic capacitance Cs in a short time.

The highest-order bit is used to control the overcurrent (pre-charge current or discharge current) for the following reason. First, to facilitate the description, it is changed from 1 gradation to 4 gradations. And the number of gradations is 256 gradations (6 bits for each of the RGB).

Even in the case of changing from 1 gradation to a white gradation, no shortage of writing of the program current occurs when changing from 1 gradation to the half-tone or higher (128 gradations or more). It is because the program current is relatively large and the charge and discharge of the parasitic capacitance Cs are relatively short.

In the case of changing from 1 gradation to below the half-tone, however, the program current is small and so it is not possible to charge and discharge the parasitic capacitance Cs sufficiently in the 1H period. Therefore, it is necessary to improve the change in the gradation to below the half-tone, such as 1 gradation to 4 gradations. In this case, the overcurrent (pre-charge current or discharge current) driving of the present invention is implemented.

As the gradation changing as above is below the half-tone, the highest-order bit is not used to specify the program current. To be more specific, in the case of changing from 1 gradation, the target gradation is below ‘011111’(the switch D5 of the highest-order bit is constantly in the off state). The present invention constantly controls the highest-order bit in the off state so as to implement the overcurrent (pre-charge current or discharge current) driving.

If the first gradation (gradation before the change) is 1, a switch D0 is on and one unit transistor 154c operates. If the target gradation is 4, a switch D2 operates and four unit transistors 154c operate. However the four unit transistors 154c cannot discharge the charge of the parasitic capacitance Cs sufficiently to a target value. Thus, the switch D5 is closed, and the transistor group 164f is operated. The switch D5 may be operated in addition to the operation of the switch D2 (the switches D5 and D2 are turned on in the first half of 1H, and only the switch D2 is turned on in the second half), or only the switch D5 may be turned on in the first half of 1H with only the switch D2 turned on in the second half.

If the switch D5 is turned on, 32 unit transistors 154c operate. Therefore, it is 32/4=8 compared to the operation of the switch D2 only, and so it is possible to discharge the charge of the parasitic capacitance Cs eight times faster. Therefore, it is possible to improve the writing of the program current.

Whether or not to turn on the switch D5 is determined by the controller circuit (IC) 760 as to each of the video data of the RGB. A determination bit KDATA is applied to the source driver circuit (IC) 14 from the controller circuit (IC) 760. KDATA is 4 bits for instance. When KDATA=0, the overcurrent (pre-charge current or discharge current) driving is not implemented. When KDATA=1, the pre-charge driving (voltage+current driving) is implemented. When KDATA=2 to 15, the overcurrent (pre-charge current or discharge current) driving is implemented, and the size of KDATA indicates the time for keeping the D5 bit on.

KDATA is held by a latching circuit 161 for the 1H period. The counter circuit 162 is reset by an HD(a synchronization signal of 1H), and is counted by the clock CLK. The data on the counter circuit 162 is compared to the data on the latching circuit 161. If the count value of the counter circuit 162 is smaller than the data value (KDATA) of the latching circuit 161, an AND circuit 163 continues to output the on voltage to an internal wiring 150b so as to maintain the on state of the switch D5. Therefore, the current of the unit transistors 154c of the transistor group 164f passes through an internal wiring 150a and the source signal line 18. The switch 151b is closed on the current program, and the switch 151a is closed and the switch 151b is open on the pre-charge driving.

FIG. 388 is a schematic diagram of the operation of the controller circuit (IC) 760. However, it is the schematic diagram of the process of one pixel line (a set of RGB). Video data DATA (8 bits×RGB) is latched in two stages of the latching circuits 771a and 771b in synchronization with the internal clock. Therefore, the video data preceding by 1H is held by the latching circuit 771b, and the current video data is held by the latching circuit 771a.

A comparator 3881 compares the video data preceding by 1H to the current video data so as to derive the value of KDATA. The video data DATA is transferred to the source driver circuit (IC) 14. The controller circuit (IC) 760 transfers an upper limit count value CNT of the counter 162 to the source driver circuit (IC) 14.

KDATA is decided by the comparator 3881. The decision is made from the video data before the change (data preceding by 1H) and the video data after the change (current data). The data preceding by 1H indicates the current potential of the source signal line 18. The current data indicates the target potential to be changed of the source signal line 18.

As shown in FIG. 380 and described, it is important to perform the writing of the program current in consideration of the potential of the source signal line 18. Writing time t is representable by T=ACV/I (A: constant of proportion, C: size of the parasitic capacitance, V: variable potential difference, I: program current). Therefore, the writing time becomes long if the variable potential difference V is large. The writing time becomes short if program current I=Iw is large.

According to the present invention, I is increased by the overcurrent (pre-charge current or discharge current) driving. If I is increased in either case, however, there occurs the case of exceeding the target potential of the source signal line 18. Therefore, in the case of implementing the overcurrent (pre-charge current or discharge current) driving, it is necessary to consider the potential difference V. KDATA is acquired from the current potential of the source signal line 18 and the target potential of the source signal line 18 decided from the next video data (current video data (video data to be applied next=(after the change: vertical direction in FIG. 389)).

There are the cases where KDATA is the time for keeping the switch D5 on. However, it may also be the current size in the overcurrent (pre-charge current or discharge current) driving. It is also possible to combine both the on time of the switch D5 (the longer it is, the longer application time of the overcurrent (pre-charge current or discharge current) applied to the source signal line 18 becomes and the larger an effective value of the overcurrent (pre-charge current or discharge current) becomes) with the size of the overcurrent (pre-charge current or discharge current) (the larger it is, the larger the effective value of the overcurrent (pre-charge current or discharge current) applied to the source signal line 18 becomes). To facilitate the description, a description will be given first as to the case where KDATA is the on time of the switch D5.

The comparator 3881 compares the video data preceding by 1H to the video data after the change (refer to FIG. 389) to decide the size of KDATA. The data of 0 or more is set to KDATA when meeting the following conditions.

In the case where the video data preceding by 1H is the low gradation region (preferably gradation 0 to ⅛ of the entire gradations, which is gradation 0 to gradation 8 in the case of 64 gradations for instance) and the video data after the change is below the half-tone region (preferably gradation 1 to ½ of the entire gradations.

It is gradation 1 to gradation 32 in the case of 64 gradations for instance.), KDATA is set. The data to be set is decided in consideration of a VI characteristic curve of the driving transistor 11a of FIG. 356. In FIG. 356, the potential difference between the voltage Vdd of the source signal line 18 and V0 (complete black display) as the voltage of the 0^{th} gradation is large. The potential difference between the voltage V0 and V1 of the 1^{st} gradation is large. The potential difference between the voltage V2 of the next 2^{nd} gradation and the voltage V1 is much smaller than the potential difference between the voltage V0 and V1. Thereafter, the potential difference becomes smaller as it proceeds to V3 and V2, V4 and V3 and so on. The potential difference becomes smaller as it gets close to the high gradation side because the VI characteristic of the driving transistor 11a is nonlinear.

The potential difference between the gradations is proportional to a discharge amount of the charge of the parasitic capacitance Cs. Therefore, it works in conjunction with the application time of the program current, that is, the application time and size of an overcurrent (pre-charge current or discharge current) Id in the case of the overcurrent (pre-charge current or discharge current) driving. For instance, the application time of the overcurrent (pre-charge current or discharge current) Id cannot be reduced even if a gradation difference between V0 preceding by 1H (gradation 0) and V1 after the change (gradation 1) is small. It is because the potential difference is large as shown in FIG. 356.

Inversely, there are the cases where it is not necessary to increase the overcurrent (pre-charge current or discharge current) even if the gradation difference is large. It is because, as for gradation 10 and gradation 32 for instance, the potential difference between the potential V10 of gradation 10 and the potential V32 of gradation 32 is small (estimated from FIG. 356) and the program current Iw of gradation 32 is large and so the parasitic capacitance Cs can be charged and discharged in a short time.

FIG. 389 shows the gradation number of the video data preceding by 1H (the potential of the source signal line 18 before the change, that is, current) on the horizontal axis. It also shows the gradation number of the current video data (the potential of the source signal line 18 after the change, that is, as the target of the change) on the vertical axis.

When changing from the 0^{th} gradation (preceding by 1H) to the 0^{th} gradation (after the change), KDATA may be 0 because of no potential change. It is because there is no potential change of the source signal line 18. When changing from the 0^{th} gradation (preceding by 1H) to the 1^{st} gradation (after the change), it is necessary to change it from the potential V0 to the potential V1 as shown in FIG. 356. As the voltage V1−V0 is large, KDATA is set at the highest value 15 (for instance). It is because the potential change of the source signal line 18 is large. When changing from the 1^{st} gradation (preceding by 1H) to the 2 gradation (after the change), it is necessary to change it from the potential V1 to the potential V2 as shown in FIG. 356. As the voltage V2−V1 is relatively large, KDATA is set at 12 which is in proximity to the highest value (for instance). It is because the potential change of the source signal line 18 is large. When changing from the 3^{rd} gradation (preceding by 1H) to the 4^{th} gradation (after the change), it is necessary to change it from the potential V3 to the potential V4 as shown in FIG. 356. As the voltage V4−V3 is relatively small, however, KDATA is set at 2 which is a small value. It is because the potential change of the source signal line 18 is small, the parasitic capacitance Cs can be charged and discharged in a short time and the target program current can be written to the pixel 16.

In the case where the gradation after the change is the half-tone or higher even if it is the low gradation region before the change, the value of KDATA is 0. It is because the program current corresponding to the gradation after the change is large enough to change the potential of the source signal line 18 to the target potential or the potential in proximity thereto within the 1H period. For instance, it is KDATA=0 in the case of changing from the 2^{nd} gradation to the 38^{th} gradation.

In the case where the gradation after the change is lower than that before the change, the overcurrent (pre-charge current or discharge current) driving is not implemented. In the case of changing from the 38^{th} gradation to the 2^{nd} gradation, it is KDATA=0. It is because, in this case, FIG. 380(b) is relevant where the program current Id is supplied to the parasitic capacitance Cs mainly from the driving transistor of the pixel 16. In the case of FIG. 380(b), it is desirable to implement the voltage+current driving method or the pre-charge voltage driving rather than the overcurrent (pre-charge current or discharge current) driving method.

It is effective to combine the overcurrent (pre-charge current or discharge current) driving method of the present invention with the driving method of increasing the reference current or the driving method of controlling the reference current ratio and the duty described in FIG. 116. It is because the overcurrent (pre-charge current or discharge current) can also be increased by increasing the reference current in the configuration of FIG. 381. Therefore, the time for charging and discharging the parasitic capacitance Cs is also reduced. The configuration of the present invention is also characterized in that it can control the size of the overcurrent (pre-charge current or discharge current) of the overcurrent (pre-charge current or discharge current) driving method by controlling the size of the reference current or the reference current ratio.

As described above, KDATA is decided by the controller circuit (IC) 760 and transmitted to the source driver circuit (IC) 14 by the differential signal (refer to FIGS. 319 and 320). The transmitted KDATA is held by the latching circuit 161 of FIG. 381, and the switch D5 is controlled.

As for the relation in the table of FIG. 389, KDATA may be set by using a matrix ROM table. It is also possible, however, to calculate (derive) KDATA with a multiplier of the controller circuit (IC) 760 by using a formula. It is also possible to determine KDATA according to the change in an external voltage of the controller circuit (IC) 760. It goes without saying that this is not limited to being implemented by the controller circuit (IC) 760 but may also be implemented by the source driver circuit (IC) 14.

According to the present invention, the size of the program current Iw changes in proportion to the reference current depending on the size of the reference current. Therefore, the size of the overcurrent (pre-charge current or discharge current) of the overcurrent (pre-charge current or discharge current) driving of FIG. 381 also changes in proportion to the size of the reference current. It goes without saying that the size of KDATA described in FIG. 389 also needs to be in conjunction with the change in the size of the reference current. To be more specific, it is desirable to have the size of KDATA in conjunction with or in view of the size of the reference current.

The technical idea of the overcurrent (pre-charge current or discharge current) driving method of the present invention is to set the size, application time and effective value of the overcurrent (pre-charge current or discharge current) correspondingly to the size of the program current and the output current from the driving transistor 11a.

The comparator 3881 or comparison means make a comparison by the video data on the RGB. However, it goes without saying that the luminance (value Y) may be acquired from the RGB data to calculate KDATA. To be more specific, KDATA is calculated, decided or computed not merely by comparing it among the RGB but by considering the color change and luminance change and also considering continuity, periodicity and change ratio of the gradation data. It also goes without saying that KDATA may be derived by considering the pixel data or similar data on surrounding pixels, rather than pixel by pixel. For instance, there is an exemplified method of dividing the screen 144 into multiple blocks and deciding KDATA by considering the video data in each block.

It also goes without saying that the above is applicable to the other embodiments, such as the display apparatus and display panel of the present invention. It also goes without saying that the above can be implemented in combination with other driving methods, such as an N-times pulse driving method (such as FIGS. 19 to 27), an N-times current driving pixel method (such as FIGS. 31 to 36), a nondisplay region division driving method (such as FIGS. 54(b) and (c)), a field sequential driving method (such as FIGS. 37 to 38), the voltage+current driving method (such as FIGS. 127 to 142), a punch-through voltage driving method (refer to the specification as regards the punch-through voltage), the pre-charge driving method (such as FIGS. 293 to 297 and FIGS. 308 to 312) and multiple-line simultaneous selection driving method (such as FIGS. 271 to 276).

In the above-mentioned embodiments, the basic configurations are those as shown in FIGS. 15, 58 and 59 for ease of the explanation. However, the present invention is not limited to this. For example, it may apply to the driver circuit (IC) 14 as shown in, for example, FIGS. 86, 161-174, 188-189, 198-200, 208-210, 221-222, 228, 230, 231, 240, 241-250. It also goes without saying that the above is applicable to the other embodiments, such as the display apparatus, display panel, drive method, scanning method, or the like of the present invention.

In FIG. 381, it is desirable to set a time period in which the switch D5 is selected at 1/32 to ¾ of 1H (1 horizontal scanning period). It is further desirable to set it at 1/16 to ½ of the 1H (1 horizontal scanning period). There are the cases where, if the period for applying the overcurrent (pre-charge current or discharge current) is long, the period for applying the normal program current becomes short so that current compensation is not good.

If the period for applying the overcurrent (pre-charge current or discharge current) is short, it is not possible to reach the target potential of the source signal line 18. It goes without saying that, in the overcurrent (pre-charge current or discharge current) driving, it is desirable to perform it up to the target potential of the source signal line 18. It is not necessary, however, to reach the target potential of the source signal line completely just by the overcurrent (pre-charge current or discharge current) driving. It is because the normal current driving is implemented after the overcurrent (pre-charge current or discharge current) driving in the first half of 1H, and an error generated by the overcurrent (pre-charge current or discharge current) driving is compensated by the program current of the normal current driving.

FIGS. 382 show the potential change of the source signal line 18 in the case of implementing the overcurrent (pre-charge current or discharge current) driving method. FIG. 382(a) shows the case of putting the switch D5 in the on state for 1/(2H) period. The switch D5 is turned on from t1 as the beginning of 1 horizontal scanning period (1H), and unitary currents of 32 unit transistors 154c are absorbed from the terminal 155. The switch D5 is kept in the on state until a t2 period of 1/(2H), and the overcurrent (pre-charge current or discharge current) Id2 passes through the source signal line 18. Therefore, the potential of the source signal line 18 is reduced to a potential Vm in proximity to a target potential Vn. Thereafter (after t2), the switch D5 is put in the off state, and the normal program current Iw passes through the source signal line 18 until the end of 1H (t3) so that the potential of the source signal line 18 becomes the target potential Vn.

The source driver circuit (IC) 14 performs a constant-current operation. Therefore, the program current Iw of the constant current passes during the t2 to t3 periods. If the parasitic capacitance Cs is charged and discharged up to the target potential by the program current Iw, a current I flows from the driving transistor 11a of the pixel 16 so that the potential of the source signal line 18 is kept to pass the program current Iw. Therefore, the driving transistor 11a is kept to pass the predetermined program current Iw. As described above, there is no need of accuracy of the overcurrent (pre-charge current or discharge current) of the overcurrent (pre-charge current or discharge current) driving. Even if there is no accuracy, it is corrected by the driving transistor 11a of the pixel 16.

FIG. 382(b) shows the case of putting the switch D5 in the on state for 1/(4H) period. The switch D5 is turned on from t1 as the beginning of 1 horizontal scanning period (1H), and unitary currents of 32 unit transistors 154c are absorbed from the terminal 155. The switch D5 is kept in the on state until a t4 period of 1/(4H), and the overcurrent (pre-charge current or discharge current) Id2 passes through the source signal line 18. Therefore, the potential of the source signal line 18 is reduced to a potential Vm in proximity to a target potential Vn. Thereafter (after t4), the switch D5 is put in the off state, and the normal program current Iw passes through the source signal line 18 until the end of 1H (t3) so that the potential of the source signal line 18 becomes the target potential Vn.

The source driver circuit (IC) 14 performs a constant-current operation. Therefore, the program current Iw of the constant current passes during the t4 to t3 periods. If the parasitic capacitance Cs is charged and discharged up to the target potential by the program current Iw, a current I flows from the driving transistor 11a of the pixel 16 so that the potential of the source signal line 18 is kept to pass the program current Iw. Therefore, the driving transistor 11a is kept to pass the predetermined program current Iw. As described above, there is no need of accuracy of the overcurrent (pre-charge current or discharge current) of the overcurrent (pre-charge current or discharge current) driving. Even if there is no accuracy, it is corrected by the driving transistor 11a of the pixel 16.

FIG. 382(c) shows the case of putting the switch D5 in the on state for 1/(8H) period. The switch D5 is turned on from t1 as the beginning of 1 horizontal scanning period (1H), and unitary currents of 32 unit transistors 154c are absorbed from the terminal 155. The switch D5 is kept in the on state until a t5 period of 1/(8H), and the overcurrent (pre-charge current or discharge current) Id2 passes through the source signal line 18. Therefore, the potential of the source signal line 18 is reduced to a potential Vm in proximity to a target potential Vn. Thereafter (after t5), the switch D5 is put in the off state, and the normal program current Iw passes through the source signal line 18 until the end of 1H (t3) so that the potential of the source signal line 18 becomes the target potential Vn.

As described above, the fixed values are the number of the unit transistors 154c in operation and the size of the unitary current of one unit transistor 154c. Therefore, it is possible to manipulate the time for charging and discharging the parasitic capacitance Cs and the potential of the source signal line 18 proportionally according to the on time of the switch D5. To facilitate the description, it is described that the parasitic capacitance Cs is charged and discharged by the overcurrent (pre-charge current or discharge current). However, it is not limited to the charge and discharge of the parasitic capacitance Cs because there is also a leak of a switch transistor of the pixel 16.

As described above, the configuration in FIG. 381 of the present invention is characterized by being able to grasp the size of the overcurrent (pre-charge current or discharge current) from the number of the unit transistors 154c in operation. The writing time t is representable by T=ACV/I (A: constant of proportion, C: size of the parasitic capacitance, V: variable potential difference, I: program current). Therefore, the value of KDATA can be decided as a theoretical figure from the parasitic capacitance (grasp able on array design) and VI characteristic of the driving transistor 11a (grasp able on array design).

The embodiment in FIGS. 382 manipulates the highest-order bit switch D5 and thereby controls the size and application time of the overcurrent (pre-charge current or discharge current) Id of the overcurrent (pre-charge current or discharge current) driving. The present invention is not limited to this. It goes without saying that any switch other than that of the highest-order bit may also be manipulated or controlled.

FIGS. 383 have the configuration in which the highest-order bit switch D7 and the second highest-order bit switch D6 are controlled by KDATA in the case where the source driver circuit (IC) 14 is comprised of 8 bits for each of the RGB. To facilitate the description, a D7 bit has 128 unit transistors 154c formed or placed thereon, and a D6 bit has 64 unit transistors 154c formed or placed thereon.

FIG. 383(a1) shows the operation of the switch D7. FIG. 383(a2) shows the operation of the switch D6. FIG. 383(a3) shows the potential change of the source signal line 18. In FIGS. 383(a), the switches D7 and D6 are manipulated simultaneously and so 128+64 unit transistors 154c operate simultaneously and flow into the source driver circuit (IC) 14 from the terminal 155. Therefore, it is possible to change the potential of the source signal line 18 at high speed from the voltage V0 of gradation 0 to the voltage V3 of gradation 3. After t2, the normal switches D are closed, and the normal program current Iw is absorbed by the source driver circuit (IC) 14 from the terminal 155.

Similarly, FIG. 383(b1) shows the operation of the switch D7. FIG. 383(b2) shows the operation of the switch D6. FIG. 383(b3) shows the potential change of the source signal line 18. In FIGS. 383(b), only the switch D7 operates and so 128 unit transistors 154c operates simultaneously and flow into the source driver circuit (IC) 14 from the terminal 155. Therefore, it is possible to change the potential of the source signal line 18 at high speed from the voltage V0 of gradation 0 to the voltage V2 of gradation 2. Speed of change is lower than FIG. 383(a). However, it is adequate because the potential to be changed is V0 to V2. After t2, the normal switches D are closed, and the normal program current Iw is absorbed by the source driver circuit (IC) 14 from the terminal 155.

Similarly, FIG. 383 (cl) shows the operation of the switch D7. FIG. 383 (c2) shows the operation of the switch D6. FIG. 383 (c3) shows the potential change of the source signal line 18. In FIGS. 383(c), only the switch D6 operates and so 64 unit transistors 154c operates simultaneously and flow into the source driver circuit (IC) 14 from the terminal 155. Therefore, it is possible to change the potential of the source signal line 18 at high speed from the voltage V0 of gradation 0 to the voltage V1 of gradation 1. Speed of change is lower than FIG. 383(b). However, it is adequate because the potential to be changed is V0 to V1. After t2, the normal switches D are closed, and the normal program current Iw is absorbed by the source driver circuit (IC) 14 from the terminal 155.

As described above, it is possible, with KDATA, to manipulate or operate the multiple switches not only in the on period thereof and change the number of the unit transistors 154c to be operated so as to achieve a proper source signal line.

In FIGS. 383, the switches D (D6 and D7) of the overcurrent (pre-charge current or discharge current) driving are operated in the period of t1 to t2. However, it is not limited thereto. It goes without saying that the period may be varied or changed according to the value of KDATA, such as t2, t3 or t4 as shown or described in FIGS. 382. It is also possible to control or change the reference current or the size of the reference current in the period for applying the overcurrent (pre-charge current or discharge current) and adjust the size of the overcurrent (pre-charge current or discharge current). The reference current or the size of the reference current is the normal values in the period for applying the normal program current.

It goes without saying that the switches to be manipulated are not limited to D7 and D6, but other switches such as D5 may also be operated or controlled simultaneously or selectively. For instance, FIG. 385 shows the embodiment. In the example of the period a, the switch D7 is put in the on state for the 1/(2H) period as the overcurrent (pre-charge current or discharge current) driving so as to apply the overcurrent (pre-charge current or discharge current) consisting of 128 unitary currents to the source signal line 18.

In the example of the period b, the switch D7 and D6 are put in the on state for the 1/(2H) period as the overcurrent (pre-charge current or discharge current) driving so as to apply the overcurrent (pre-charge current or discharge current) consisting of 128+64 unitary currents to the source signal line 18.

In the example of the period c, the switch D7, D6 and D5 are put in the on state for the 1/(2H) period as the overcurrent (pre-charge current or discharge current) driving so as to apply the overcurrent (pre-charge current or discharge current) consisting of 128+64+32 unitary currents to the source signal line 18.

In the example of the period d, the switches D7, D6, D5 and the switch of the video data not falling under them (for instance, the switch D2 if the video data is 4) are put in the on state for the 1/(2H) period as the overcurrent (pre-charge current or discharge current) driving so as to apply the overcurrent (pre-charge current or discharge current) consisting of 128+64+32+a unitary currents to the source signal line 18.

According to the embodiments, the period for passing the overcurrent (pre-charge current or discharge current) is from the beginning of 1H. However, the present invention is not limited thereto. FIGS. 384 (a1) and (a2) show the method of operating the switch from t1 as the beginning of 1H to t2 of 1/(2H). FIGS. 384 (b1) and (b2) show the method of operating the switch from t4 to t5 of 1/(2H). The application time of the overcurrent (pre-charge current or discharge current) is the same as that in FIGS. 384(a). As the potential of the source signal line 18 is prescribed by the charge and discharge of the parasitic capacitance Cs, the effective value is equal whichever the application time of the overcurrent (pre-charge current or discharge current) is. It is necessary, however, to have the application time of the normal program current at the end of 1H. It is because an accurate target potential (at which the driving transistor 11a can pass an accurate program current) can be set by applying the normal program current.

In FIGS. 384(c1) and (c2), the switch is operated from t1 as the beginning of 1H to t4 of 1/(4H), and from t2 of 1H to t5 of 1/(4H). The effective value of the application time of the overcurrent (pre-charge current or discharge current) is the same as that in FIGS. 384 (a). As described above, according to the present invention, it is possible to divide the application time of the overcurrent (pre-charge current or discharge current) into a plurality. An application start time of the overcurrent (pre-charge current or discharge current) is not limited to the beginning of 1H.

As described above, the overcurrent (pre-charge current or discharge current) driving method of the present invention is not limited to application timing of the overcurrent (pre-charge current or discharge current). However, it needs to be the time period wherein the program current is applied when the current program of the relevant pixel 16 is finished. It goes without saying that it is not limited thereto when the current program of the pixel 16 does not need accuracy. To be more specific, the 1H period may be finished in the state of applying the overcurrent (pre-charge current or discharge current).

The operation of passing the overcurrent (pre-charge current or discharge current) through the source signal line 18 is important in the overcurrent (pre-charge current or discharge current) driving of the present invention. What generates the overcurrent (pre-charge current or discharge current) is not limited to the unit transistors 154c. For instance, it goes without saying that it is possible to form or configure the constant current circuit and variable current circuit connected to the terminal 155 and operate these current circuits so as to generates the overcurrent (pre-charge current or discharge current).

In FIG. 381, the configuration or structure used for the gradation display of the source driver circuit (IC) 14 (used for the current program driving) is used for the overcurrent (pre-charge current or discharge current) driving. The present invention is not limited to this. As shown in FIG. 386, it is also possible to separately form or configure an overcurrent (pre-charge current or discharge current) transistor 3861 for generation of the overcurrent (pre-charge current or discharge current) used for the overcurrent (pre-charge current or discharge current) driving.

The overcurrent (pre-charge current or discharge current) transistor 3861 may be in the same size as the unit transistor 154c and configured by forming a plurality of the unit transistors 154c. It may also be different from the unit transistor 154c in size, WL ratio or WL form. However, they should be the same in all output stages.

In FIG. 386, the gate terminal potential of the overcurrent (pre-charge current or discharge current) transistor 3861 is the same as that of the unit transistor 154c. It is possible, by rendering them the same, to easily control the size of the overcurrent (pre-charge current or discharge current) outputted from the overcurrent (pre-charge current or discharge current) transistor 3861 by means of the reference current control. It is also possible to estimate the output overcurrent (pre-charge current or discharge current) such as the size of the overcurrent (pre-charge current or discharge current) transistor 3861 so as to facilitate the design. However, the present invention is not limited to this.

It is also possible to render the gate terminal potential of the overcurrent (pre-charge current or discharge current) transistor 3861 different from the terminal potential of the unit transistor 154c. It is possible to control the size of the overcurrent (pre-charge current or discharge current) by manipulating the gate terminal potential of the overcurrent (pre-charge current or discharge current) transistor 3861 rendered different. It is also possible to separate a drain terminal (D) of the overcurrent (pre-charge current or discharge current) transistor 3861 from the drain terminal (D) of the unit transistors 154c so as to control or adjust the voltage to be applied. It is also possible, by adjusting or controlling a drain terminal potential, to adjust or control the size of the overcurrent (pre-charge current or discharge current) outputted from the overcurrent (pre-charge current or discharge current) transistor 3861.

The above is also applicable to the other embodiments of the present invention. In FIG. 381 for instance, it is possible to adjust or control the size of the overcurrent (pre-charge current or discharge current) by controlling or adjusting the drain terminal potential.

In FIG. 386, the overcurrent (pre-charge current or discharge current) driving of the present invention is implemented by controlling on and off of a switch Dc with a signal applied to 150b. It is possible, by adopting the configuration in FIG. 386, to implement the overcurrent (pre-charge current or discharge current) driving irrespective of the size of the video data. The other configurations and operations are described or will be described in FIGS. 380 to 390, and so the description thereof will be omitted.

It goes without saying that the above as shown in FIGS. 381, 386, or the like is applicable to the other embodiments, such as the display apparatus and display panel of the present invention. It goes without saying that it can be implemented in combination with the other driving methods, such as the N-times pulse driving method (such as FIGS. 19 to 27), an N-times current driving pixel method (such as FIGS. 31 to 36), nondisplay region division driving method (such as FIGS. 54(b) and (c)), field sequential driving method (such as FIGS. 37 to 38), voltage+current driving method (such as FIGS. 127 to 142), punch-through voltage driving method (refer to the specification as regards the punch-through voltage), pre-charge driving method (such as FIGS. 293 to 297 and FIGS. 308 to 312) and multiple-line simultaneous selection driving method (such as FIGS. 271 to 276).

In particular, it is desirable to implement the overcurrent (pre-charge current or discharge current) driving described in FIGS. 381 and 386 in combination with the voltage+current driving (pre-charge driving). FIG. 390 is a schematic diagram of that embodiment. In FIG. 390, the video data indicates the change in the gradation (change in the video data) written to the pixel 16. The source signal line potential indicates the potential change of the source signal line 18. It is the case where the number of gradations is 256.

FIG. 380(b) shows the state in the case where the video data changes from the 255 (white) gradations to 0 gradation. In this case, the pre-charge voltage is applied to the source signal line 18 first. As the program current Iw of the driving transistor 11a of the pixel 16 is 0, the gate terminal potential rises in the voltage Vdd direction so as not to pass the current. At 0 gradation, it is put in a completely black display state by the punch-through voltage driving. The overcurrent (pre-charge current or discharge current) driving is not implemented.

In the case where the video data changes from 0 (black) gradation to 2 gradations, it is in the state of FIG. 380(a). In this case, the overcurrent (pre-charge current or discharge current) is applied to the source signal line 18 for the period of t3 to t4. The driving transistor 11a of the pixel 16 does not operate generally. The program current driving is performed in the period of t4 to t5. In the case where the potential of the source signal line 18 is overly reduced by the overcurrent (pre-charge current or discharge current) driving, the driving transistor 11a of the pixel 16 operates and increases the potential of the source signal line 18 on the anode voltage side so as to become the voltage V2 as shown in FIG. 390.

The gate terminal voltage of the driving transistor 11a becomes the voltage V2 because of the above operation so that an accurate program current can be passed through the EL element 15.

The program current is small in the relatively low gradation region in the case where the video data changes from 2 gradations to 16 gradations. The operation is in the state of FIG. 380(a). In this case, the overcurrent (pre-charge current or discharge current) is applied to the source signal line 18 for the period of t5 to t6. The driving transistor 11a of the pixel 16 does not operate generally. The program current driving is performed in the period of t6 to t7. In the case where the potential of the source signal line 18 is kept adequate by the overcurrent (pre-charge current or discharge current) driving, the potential of the source signal line 18 does not change as shown in FIG. 390. To be more specific, the driving transistor 11a of the pixel 16 does not operate. In the case where the potential of the source signal line 18 is lower than the target value, the source driver circuit (IC) 14 draws in the program current in the period of t6 to t7 so as to reach the target potential of the source signal line 18.

As shown in FIG. 390, as for the potential of the source signal line 18, the gate terminal voltage of the driving transistor 11a becomes the voltage V16 so that the accurate program current can be passed through the EL element 15.

In the case where the video data changes from 16 gradations to 90 gradations, the program current is large. The operation is in the state of FIG. 380(a). In this case, the program current driving is performed over the entire period of t7 to t8. To be more specific, the pre-charge voltage driving and the overcurrent (pre-charge current or discharge current) driving are not implemented. As described above, the present invention changes the KDATA value and also changes the driving method according to the change ratio of the gradation data and the size thereof before the change.

FIGS. 435 show another embodiment (a deformation example) of the driving method shown in FIG. 390. FIG. 435(a) shows the driving method of implementing a voltage pre-charge of 0-gradation voltage (V0) at the low gradation below a certain level. In FIG. 435(a), the voltage pre-charge of 0-gradation voltage (V0) is implemented when the gradations written to the pixel 16 are 5 gradations or less. In FIG. 435(a), the voltage V0 is applied in the 1H periods of t0 to t1, t3 to t4 and t5 to t6. The gradation data 5 is written in 1H of t0 to t1, the gradation data 3 is written in 1H of t3 to t4, and the gradation data 4 is written in 1H of t5 to t6. Therefore, all of them have the gradation numbers of 5 gradations or less. The program current is small in these low gradation regions, and so the writing is difficult. Therefore, the voltage V0 is applied to secure a black level first, and then the current program is implemented. At the gradation numbers of 6 gradations or more, a relatively sufficient program current is applied to the source signal line 18. At the 6 gradations or more, the voltage pre-charge is not implemented and only the program current driving is implemented.

FIGS. 435(b) shows the driving method of implementing the voltage pre-charge of a corresponding voltage at the low gradation below a certain level. In FIG. 435(b), the voltage pre-charge is implemented when the gradations written to the pixel 16 are 5 gradations or less. In FIG. 435(b), the voltage is applied in the 1H periods of t0 to t1, t3 to t4 and t5 to t6. As the gradation data 5 is written in 1H of t0 to t1, the voltage V5 corresponding to gradation 5 is applied. As the gradation data 3 is written in 1H of t3 to t4, the voltage V3 corresponding to gradation 3 is applied. As the gradation data 4 is written in 1H of t5 to t6, the voltage V4 corresponding to gradation 4 is applied. Therefore, the voltage pre-charge is implemented when all the gradation numbers are 5 gradations or less. The program current is small in these low gradation regions, and so the writing is difficult. Therefore, at the predetermined low gradation, the corresponding voltage is applied to secure the predetermined black level first, and then the current program is implemented. At the gradation numbers of 6 gradations or more, a relatively sufficient program current is applied to the source signal line 18. At the 6 gradations or more, the voltage pre-charge is not implemented and only the program current driving is implemented.

Other embodiments of the present invention will be explained herein referring to figures. FIG. 393 shows another embodiment of the overcurrent (pre-charge current or discharge current) driving method of the present invention. There is one overcurrent transistor 3861 in FIG. 386. In FIG. 393, a plurality of the overcurrent transistors 3861 are formed or placed, and the gate terminals of the overcurrent transistors 3861 are connected to a gate wiring different from the unit transistor group 431c.

It is possible, by having the configuration in FIG. 393, to set or adjust the size of the overcurrent (pre-charge current or discharge current) freely without being restricted by the size of the reference current Ic. It is also possible to set the size of the overcurrent (pre-charge current or discharge current) freely with the switch DC by configuring it with a plurality of the overcurrent (pre-charge current or discharge current) transistors 3861.

The overcurrent transistors 3861 are common to RGB circuits. As shown in FIG. 397, the reference current of R Icr is changed or adjusted by IRDATA which is a set value of the reference current of R (red). Similarly, the reference current of G Icg is changed or adjusted by IGDATA which is a set value of the reference current of G (green). Similarly, the reference current of B Icb is changed or adjusted by IBDATA which is a set value of the reference current of B (blue).

As shown in FIG. 397, the overcurrent (pre-charge current or discharge current) Id is common to the RGB as shown in FIG. 397. To be more specific, Id of an output stage circuit of R (refer to FIG. 393), Id of the output stage circuit of G and Id of the output stage circuit of B are the same. The size of Id and/or change timing of Id is set in the controller circuit (IC) 760 by setup data IKDATA 4 bits of the overcurrent (pre-charge current or discharge current). As shown in FIG. 393, this Id passes through a master circuit of the current mirror circuit comprised of one transistor 158d or a transistor group consisting of multiple transistors 158d. In FIG. 393, one transistor 158d is shown. However, it goes without saying that it may be configured or formed by multiple transistors 158d.

In FIG. 386, it is possible to set the size of the program current individually in the RGB circuits. It is not desirable, however, to set the overcurrent (pre-charge current or discharge current) individually for the RGB. It is because, as described in FIGS. 380, the overcurrent (pre-charge current or discharge current) controls the charge and discharge of the parasitic capacitance Cs. The parasitic capacitance Cs is the same in the source signal lines 18 as to the R, G and B. Therefore, if the overcurrents (pre-charge current or discharge current) of the RGB are different, the writing speed of the overcurrents (pre-charge current or discharge current) is different and the potential of the source signal line at the end of 1H is different as shown in FIG. 395.

In FIG. 395, the overcurrent (pre-charge current or discharge current) of B in dashed line is the largest. Therefore, it reaches the voltage V2 equivalent to gradation 2 from the voltage V0 equivalent to gradation 0 in the 1H period. The overcurrent (pre-charge current or discharge current) of Gin dotted line is the smallest. Therefore, it does not reach the voltage V2 equivalent to gradation 2 from the voltage V0 equivalent to gradation 0 in the 1H period. R is indicated in full line. As shown in FIG. 395, it is in an intermediate state between G and B. If in such a state, the white balance will be displaced after 1H. As FIG. 395 is in the low gradation region, however, there is no problem from a practical viewpoint even if the white balance is displaced.

It goes without saying that the problem described in FIG. 395 can be solved by rendering the parasitic capacitance different among the R, G and B. To be more specific, in the state of FIG. 395, the parasitic capacitance Cs of the source signal line 18 of. R is rendered larger than the parasitic capacitance Cs of the source signal line 18 of G. Furthermore, the parasitic capacitance Cs of the source signal line 18 of B is rendered larger than the parasitic capacitance Cs of the source signal line 18 of R. As a method of rendering the parasitic capacitance Cs larger, the method of forming or configuring the capacitor with polysilicon circuits at the end of the source signal line 18 for each of the RGB will be exemplified.

The configuration for reducing the parasitic capacitance of the source signal line 18 as to the RGB will also be exemplified. The parasitic capacitance Cs of the source signal line 18 of G is rendered smaller than the parasitic capacitance Cs of the source signal line 18 of R. Furthermore, the parasitic capacitance Cs of the source signal line 18 of R is rendered larger than the parasitic capacitance Cs of the source signal line 18 of B. The configuration for changing wiring width of the source signal line 18 for each of the RGB will be exemplified as a method of reducing the parasitic capacitance Cs.

If the width of the source signal line 18 becomes smaller, the size of the parasitic capacitance Cs becomes smaller. In the current driving method, the current passing through the source signal line 18 is in μA order. Therefore, there is no disadvantage in implementing the current driving method even if the width of the source signal line 18 is small and the resistance value of the source signal line 18 is high.

As described above, according to the present invention, the parasitic capacitances Cs of one or more source signal lines 18 of the RGB are different from the parasitic capacitances Cs of the other source signal lines 18. To implement it, the configuration for changing the wiring width of the source signal line 18 will be exemplified. The configuration for making or placing the capacitor to be the capacitance and electrically connecting it to the source signal line 18 will be exemplified.

The voltage V0 equivalent to gradation 0 is decided by the driving transistor 11a of the pixel 16. Under normal circumstances, the driving transistor 11a is in the size common to the RGB. Therefore, the voltage V0 is matching among the RGB. There are many cases where the charge and discharge of the parasitic capacitance Cs is performed in reference to the voltage V0.

As shown in FIG. 397, a charge and discharge curve of the source signal line 18 will not become different among the RGB as shown in FIG. 395 by rendering the overcurrent (pre-charge current or discharge current) Id common to the RGB circuits. To be more specific, it is desirable to render the overcurrent (pre-charge current or discharge current) Id the same to the RGB.

A regulator circuit of the overcurrent (pre-charge current or discharge current) Id is the electronic regulator 501b of FIG. 397. The electronic regulator 501b can be varied or changed by IKDATA frame by frame or pixel line by pixel line. There is also an exemplified configuration in which the screen 144 is divided into multiple regions, the electronic regulator 501b is placed in each of the divided regions, and the current Id is varied or adjusted in each of the divided regions. It goes without saying that the above is also applicable to the electronic regulator 501a of the reference current Ic.

FIG. 397 has the configuration for adjusting the overcurrent (pre-charge current or discharge current) Id with the electronic regulator 501. However, the present invention is not limited to this. It is also possible, as shown in FIG. 396(a), to adjust it with a semifixed regulator Vr. It is also possible to apply an adjustment voltage to a terminal 2983b. It is desirable to adjust a built-in resistor R2 to be a stipulated value by performing the trimming.

As shown in FIG. 396(b), it is also possible to adjust the overcurrent (pre-charge current or discharge current) Id with the built-in resistors Ra and Rb. It is desirable to adjust at least one of the built-in resistors Ra and Rb to be a stipulated value by performing the trimming. The resistor R2 may be either externally mounted as shown or built into the source driver circuit (IC) 14. The resistor R2 may also be adjusted by the semifixed regulator Vr. It is also possible to apply the adjustment voltage to the terminal 2883a.

In FIGS. 372 and 396, the resistors R are built into the source driver circuit (IC) 14 and so on. However, it is not limited thereto. It goes without saying that they may be placed as terminating resistors outside the source driver IC.

It is possible, by configuring or forming it as above, to easily set, adjust or change the overcurrent (pre-charge current or discharge current) Id of the RGB.

FIGS. 398 shows a placement relation between an output stage 431c for outputting the program current Iw and an output stage 431e for outputting the overcurrent (pre-charge current or discharge current). As for the output stage 431c, the size of the program current varies according to the reference current which is different (it goes without saying that it may be the same) among the RGB. The program current Iw outputted from the output stage 431c is outputted from the terminal 155. The output stage 431e for outputting the overcurrent (pre-charge current or discharge current) is the same (it goes without saying that it may be different) among the RGB.

The size of the overcurrent (pre-charge current or discharge current) varies according to the reference current Id. The overcurrent (pre-charge current or discharge current) outputted from the output stage 431e is outputted from the terminal 155 for outputting the program current Iw. The terminal 155 also has an output circuit of the pre-charge voltage Vpc connected thereto.

FIGS. 399 shows another embodiment for generating the reference current Id of an overcurrent (pre-charge current or discharge current) circuit. A basic current Ie is generated by the data IKDATA for the electronic regulator 501b and the constant current circuit consisting of the resistor R2. The current Ie passes through the transistors 158a and 158b. The transistors 158b and 158e configure the current mirror circuit of a predetermined current mirror ratio. Multiple transistors 158e are formed or placed against the transistor 158b. In FIG. 399, the transistors 158e are formed to be equal to the number of the output stages. In the case of 160 RGB for instance, 160×3=480 transistors 158e are formed or placed.

Each of the transistors 158e transfers the reference current Id to the transistors 158b by means of current connection. The size, change timing or control state of an overcurrent transistor 3861a is decided by the transferred current Id.

FIGS. 249, 250 and 299 to 305 described cascade connection of the reference current. It is also desirable to deliver and receive the reference current Id of the overcurrent (pre-charge current or discharge current) between the source driver circuits (ICs) as shown in FIG. 400.

It goes without saying that the contents regarding adjustment methods such as the trimming method, trimming technique and trimming structure described in FIGS. 162, 165, 169, 170, 172, 175 and 176 are also applicable to the cases where the source driver circuits (IC) 14 are cascade-connected. It is possible, by using the trimming technique and so on, to adjust the reference current Ic of adjacent source driver circuits (IC) 14 so as to have no difference in luminance on the connected screen 144. The trimming is performed to the resistors R1, transistors 158a and 158b in FIGS. 61, 146 and 188. It is also possible to perform the trimming to the resistors R in the DA circuit 501 for adjusting the reference current. It may also be performed by trimming to decrease the number of the transistors 158b of the unit transistor group 431b in FIGS. 48 and 49 and by decreasing the number of sub-unit transistors 5471 or the unit transistors 154 in FIGS. 547 to 550. It is also possible to apply heat or a laser to the transistors 158 and activate or deactivate them so as to increase and decrease the outputted current.

As described above, the trimming is performed to the resistors or transistors to adjust the reference current Ic to the predetermined value. The adjustment is not limited to the reference current. Any method may be used as long as it is the method whereby the program currents of the output terminals of the adjacent source driver circuits (IC) 14 to be cascade-connected match.

In FIG. 400, the external resistor R is connected to the source driver circuit (IC) 14a. The size of the reference current Icr of R is set or adjusted by a resistor R1r. The size of the reference current Icg of G is set or adjusted by a resistor R1g. The size of the reference current Icb of B is set or adjusted by a resistor R1b.

Likewise, the size of the overcurrent (pre-charge current or discharge current) Id is set or adjusted by the resistor R2. The reference currents Icr, Icg, Icb and Id generated by the above configuration are delivered to the source driver circuits (IC) 14 adjacent in a wiring 2081. It goes without saying that the reference currents may also be generated or adjusted by the configurations in FIGS. 396 and 397.

The embodiment has the overcurrent transistor 3861 and the reference current Id generated by the source driver circuit (IC) 14. However, the present invention is not limited to this. It is also possible, for instance, to configure it as shown in FIG. 401. FIG. 401 has the configuration in which the overcurrent transistors 3861 are formed or placed on the array board 30. The overcurrent transistors 3861 are operated by the voltage outputted from the source driver circuit (IC) 14 to a gate wiring 4011 so as to pass the overcurrent (pre-charge current or discharge current) to the source signal line 18.

As described above, the overcurrent (pre-charge current or discharge current) circuit may be configured or formed by using the polysilicon technique and so on. The overcurrent (pre-charge current or discharge current) circuit may be configured by the driver circuit (IC) to be mounted on the terminal of the source signal line 18 on the array board 30.

In FIG. 401, the overcurrent (pre-charge current or discharge current) passed by the overcurrent transistor 3861 is adjusted by the voltage applied to the gate wiring 4011. However, the present invention is not limited to this. For instance, it is also possible, by using low-temperature polysilicon technique, to form the current mirror circuit consisting of the transistors 158d and the overcurrent transistors 3861 shown in FIG. 399 on the array board 30. And the reference current Id described in FIGS. 396, 397 and 399 may be applied to the current mirror circuit comprising the overcurrent transistors 3861. To be more specific, the reference current Id of the overcurrent (pre-charge current or discharge current) is generated by the source driver circuit (IC) 14.

FIG. 392(a) is a configuration example of the overcurrent (pre-charge current or discharge current) circuit of the source driver circuit (IC) 14 of the present invention. The transistor 158d and the overcurrent transistors 3861 comprise the current mirror circuit. The size of the overcurrent (pre-charge current or discharge current) Ik is controlled by the two switches Dc. The switch Dc0 has one overcurrent transistor 3861 connected thereto, and the switch Dc1 has two overcurrent transistors 3861 connected thereto.

The overcurrent transistor 3861 has the same configuration as the unit transistor 154 described in FIGS. 15 (formed or configured by the same technical idea). Therefore, the matters described as to the unit transistor 154 are applied as-is or correspondingly to the configuration or description of the overcurrent transistors 3861. Therefore, the description will be omitted.

Control is exerted by 2 bits as to the control of a switch Dp for applying the pre-charge voltage Vpc to the terminal 155 and the control of the switch Dc for applying the overcurrent (pre-charge current or discharge current) to the terminal 155. These bits are a bit K (1^{st} bit) and a bit P (0^{th} bit: LSB). Therefore, four states are controllable.

The table of FIGS. 392(b) shows the four states. When (K, P)=0, control is exerted to (Dp, Dc0, Dc1)=(0, 0, 0). 0 indicates the state in which the switch is open, and 1 indicates the state in which the switch is closed.

When (K, P)=0, the pre-charge voltage (program voltage) control switch Dp is open, and the overcurrent control switches Dc are also open. Therefore, neither the pre-charge voltage nor the overcurrent (pre-charge current or discharge current) is outputted (applied) from the terminal 155.

When (K, P)=1, control is exerted to (Dp, Dc0, Dc1)=(1, 0, 0). The pre-charge voltage (program voltage) control switch Dp is in the closed state, and both the overcurrent control switches Dc are in the open state. Therefore, the pre-charge voltage Vpc is outputted from the terminal 155. However, the overcurrent (pre-charge current or discharge current) is not outputted (applied) therefrom.

When (K, P)=2, control is exerted to (Dp, Dc0, Dc1)=(0, 1, 0). The pre-charge voltage (program voltage) control switch Dp is in the open state. As for the overcurrent control switches Dc, Dc0 is in the closed state while Dc1 is in the open state. Therefore, the pre-charge voltage Vpc is not outputted from the terminal 155. As for the overcurrent (pre-charge current or discharge current), the output current equivalent to one overcurrent transistor 3861 is applied to the source signal line 18.

When (K, P)=3, control is exerted to (Dp, Dc0, Dc1)=(0, 0, 1). The pre-charge voltage (program voltage) control switch Dp is in the open state and the overcurrent control switches Dc, Dc0 and Dc1 are in the closed state. Therefore, the pre-charge voltage Vpc is not outputted from the terminal 155. As for the overcurrent (pre-charge current or discharge current), the output current equivalent to two overcurrent transistors 3861 is applied to the source signal line 18.

As described above, it is possible to control the pre-charge voltage and the overcurrent (pre-charge current or discharge current) with the 2-bit signals (K and P).

FIG. 392(b) requires a decoding circuit of (K and P). FIG. 391 shows a configuration table requiring no decoding circuit. In FIG. 391, K0 and K1 are the signals of the switches for controlling the overcurrent (pre-charge current or discharge current). K0 is the bit for controlling open and close of Dc0. K1 is the bit for controlling open and close of Dc1 (refer to FIG. 392(a)). In FIG. 391, P is a signal of switch which controls pre-charge voltage. It is the bit for controlling open and close of Dp (refer to FIG. 392(a)).

When (P, K0, K1)=(0, 0, 0), control is exerted to (Dp, Dc0, Dc1)=(0, 0, 0). The pre-charge voltage (program voltage) control switch Dp is in the open state, and the overcurrent control switches Dc0 and Dc1 are also in the open state. Therefore, neither the pre-charge voltage Vpc nor the overcurrent (pre-charge current or discharge current) is outputted (applied) from the terminal 155.

When (P, K0, K1)=(1, 0, 0), control is exerted to (Dp, Dc0, Dc1)=(1, 0, 0). The pre-charge voltage (program voltage) control switch Dp is in the closed state, and both of the overcurrent control switches Dc0 and Dc1 are in the open state. Therefore, the pre-charge voltage Vpc is outputted from the terminal 155 while the overcurrent (pre-charge current or discharge current) is not outputted from the terminal 155.

For example, when (P, K0, K1)=(1, 1, 1), control is exerted to (Dp, Dc0, Dc1)=(1, 1, 1). The pre-charge voltage (program voltage) control switch Dp is in the closed state, and the overcurrent control switches Dc0 and Dc1 are also in the closed state. Therefore, both the pre-charge voltage Vpc and the overcurrent (pre-charge current or discharge current) are outputted from the terminal 155.

Hereunder, the pre-charge voltage (program voltage) control switch Dp and the overcurrent control switches Dc0, Dc1 are independently controlled according to the values of (P, K0, K1). Therefore, it is possible to simultaneously implement the pre-charge voltage application and the overcurrent (pre-charge current or discharge current) application.

It goes without saying that, in FIGS. 391 and 392, the overcurrent (pre-charge current or discharge current) and the pre-charge voltage can be controlled with higher accuracy by adding the bit for closing the switches (Dp, Dc0, Dc1).

FIG. 393 shows the embodiment in which the switch for controlling the overcurrent (pre-charge current or discharge current) is 3 bits. The current of one overcurrent transistor 3861 is applied to the source signal line 18 by turning on (closing) the switch Dc0. The current of two overcurrent transistors 3861 is applied to the source signal line 18 by turning on (closing) the switch Dc1. The current of four overcurrent transistors 3861 is applied to the source signal line 18 by turning on (closing) the switch Dc2. Similarly, the current of seven overcurrent transistors 3861 is applied to the source signal line 18 by turning on (closing) the switches Dc0, Dc1, Dc2.

In FIG. 393, the period for applying the overcurrent (pre-charge current or discharge current) to the terminal 155 is controlled by a td period of the signal applied to the terminal 2883 of the source driver circuit (IC) 14. The td period is the period for turning on (closing) a switch 151c.

The td period may be controlled by the counter circuit (not shown) configured or formed inside the source driver circuit (IC) 14. A td period setting command is transmitted from the controller circuit (IC) 760 to the source driver circuit (IC) 14 by a command signal described in FIGS. 360, 361, 362 and 367. It goes without saying that td may be a fixed value such as ½ of 1H, as a matter of course. It is desirable that the switches 151b and 151c exert control in synchronization.

FIG. 402 shows low-order 3 bits of the video data DATA of FIGS. 424 and 425 used as on and off control time of the switches Dc. To be more specific, bits D2 to D0 are decoded by a predetermined rule to be used as time control bits T2 to T0. The bits T2 to T0 change the meaning according to data contents of a pre-charge voltage control bit (P) and an overcurrent control bit (K).

When the pre-charge voltage control bit (P) is 1, a voltage pre-charge is implemented. When it is 0, the voltage pre-charge is not implemented. When the overcurrent control bit (K) is 1, the overcurrent (current pre-charge) is implemented. When it is 0, the current pre-charge is not implemented. When the pre-charge voltage control bit (P) is 1 and the overcurrent control bit (K) is 1, the voltage pre-charge is implemented and the overcurrent (current pre-charge) is implemented.

If the voltage pre-charge is implemented, the potential of the source signal line 18 is forcibly changed to the predetermined voltage. The overcurrent (current pre-charge) becomes the operation from the potential of the source signal line 18 having the voltage pre-charged. Therefore, the current pre-charge of FIG. 402(b) when P=1, K=1 is an absolute-value operation. It is because the potential of the source signal line 18 becomes the predetermined voltage due to the voltage pre-charge, and the change occurs from this potential. For that reason, T2 to T0 is absolute on time control of the switches Dc. It is also desirable to exert the absolute on time control so as to adjust it to the target potential of the source signal line 18.

When the pre-charge voltage control bit (P) is 0 and the overcurrent control bit (K) is 1, the voltage pre-charge is not implemented. The overcurrent (current pre-charge) is implemented. If the voltage pre-charge is not implemented, the potential of the source signal line 18 is kept in the state preceding (by 1H. Therefore, the overcurrent (current pre-charge) is a relative operation from the previous potential of the source signal line 18. The current pre-charge of FIG. 402(c) when P=1, K=1 is a relative value operation. For that reason, T2 to T0 is relative on time control of the switches Dc.

In FIGS. 402, the low-order 3 bits of the video data DATA is decoded and used as the on and off control time of the switches Dc. A decoding conversion table is changed according to the values of P and K. In FIG. 402(b), the larger the value of D2 to D0 is, the larger the size of T2 to T0 becomes. It is because the overcurrent (pre-charge current or discharge current) Id is applied after the predetermined voltage is applied. In FIG. 402(c), the larger the value of D2 to D0 is, the smaller the size of T2 to T0 becomes. It is because the pre-charge voltage is not applied but the overcurrent (pre-charge current or discharge current) Id is applied from the potential of the source signal line 18 before applying the overcurrent (pre-charge current or discharge current) so as to change the potential of the source signal line 18.

In FIG. 402, T2 to T0 is time. However, the present invention is not limited thereto. It may be replaced by the size of the overcurrent (pre-charge current or discharge current). It goes without saying that it is possible to combine both the application time control and size control of the overcurrent (pre-charge current or discharge current).

In FIG. 393, the switch 151c is formed or placed. However, it is not necessary to form or place the switch 151c as shown in FIG. 394(a). It is because the constant current circuits (431c, 3861 and so on) have such high impedance that no problem occurs even if shorted.

In FIGS. 392, 393 and 386, it consists of multiple overcurrent transistors for passing a unitary overcurrent (pre-charge current or discharge current) through the switches Dc. However, the present invention is not limited thereto. As shown in FIG. 394(b) for instance, it goes without saying that one overcurrent transistor 3861 may be formed or placed on each switch Dc. In FIG. 394(b), one overcurrent transistor 3861a is placed or formed on the switch Dc0. One overcurrent transistor 3861b is placed or formed on the switch Dc1. One overcurrent transistor 3861c is placed or formed on the switch Dc2. The overcurrent transistors 3861a to 3861c output the overcurrents (pre-charge currents or discharge currents) of different sizes. The size of the overcurrent (pre-charge current or discharge current) can be easily adjusted or designed according to the WL ratio, size or form of the overcurrent transistor 3861.

FIG. 399 has the configuration for passing the reference current Id of the overcurrent (pre-charge current or discharge current) through one transistor 158e. As described in FIG. 47, however, it is possible to form multiple transistors 158b and configure them as the unit transistor group 431b to reduce the variations in Id. The embodiment is shown in FIG. 405. The reference current Id of the overcurrent (pre-charge current or discharge current) is generated by four transistors 158e.

In FIG. 405, the reference current Ic and the reference current Id of the overcurrent (pre-charge current or discharge current) change according to IDATA inputted to the electronic regulator 501. The ratio of size between the reference current Ic and the reference current Id of the overcurrent (pre-charge current or discharge current) is implemented by differentiating the transistor 158a for passing the reference current Ic and the transistor 158c for passing the reference current Id of the overcurrent (pre-charge current or discharge current) in the form and so on.

In FIG. 405, there are one transistor 158a for passing the reference current Ic and four transistors 158c for passing the reference current Id of the overcurrent (pre-charge current or discharge current) Therefore, it is possible to configure the relation of reference current Ic×4=reference current Id even in the case where the transistor 158a and the transistor 158c are in the same form.

In FIG. 405, four overcurrent transistors 3861 corresponding to the switches Dc are formed or placed. It is possible to configure the output stage with multiple overcurrent transistors 3861 for passing a small overcurrent (pre-charge current or discharge current) so as to decrease output variations. The above is also described in FIG. 15, and so a description thereof will be omitted.

In FIG. 405, the switch Dc is time-controlled by an on-off signal applied to the internal wiring 150b as shown in FIG. 393 so as to control the effective current outputted from the terminal 155. The on and off states of the switches 151a and 151b are in an opposite relation. Therefore, when the pre-charge voltage Vpc is applied to the terminal 155, control is exerted not to apply the overcurrent (pre-charge current or discharge current) to the terminal 155.

FIGS. 127 to 143, FIG. 405 and FIGS. 308 to 313 are the embodiments for implementing the combination of the voltage driving and current driving. However, it is not necessary to render the bit number of VDATA of the voltage driving the same as that of IDATA of the current driving. For instance, IDATA of the program current driving may be 8 bits (256 gradations) and VDATA of the pre-charge voltage driving may be 6 bits (64 gradations).

The embodiment is shown in FIG. 434. In FIG. 434, the source driver circuit (IC) 14 is configured to be able to output the program current data IDATA correspondingly to the gradation number (number of stages). However, only one piece of the pre-charge voltage data VDATA is associated with four pieces of IDATA. To be more specific, if the program current driving data IDATA is 8 bits (256 gradations), the pre-charge voltage driving data VDATA is 6 bits (64 stages).

In FIG. 434, one piece of VDATA is associated with four pieces of IDATA at regular intervals. The present invention is not limited to this. It is possible to narrow the intervals of VDATA in the low gradation region and widen them in the high gradation region.

Needless to say, the above can be applied to other embodiments herein. It goes without saying that the embodiment can be configured by combining them.

FIG. 406 is a schematic diagram for describing a genetic relation between the program current Iw (generated according to the on and off states of the switches D0 to D7) and the overcurrent (pre-charge current or discharge current) Id (to facilitate the description, the transistor 158d and the overcurrent transistors 3861 configure the current mirror circuit of a current mirror ratio 1, and the overcurrent (pre-charge current or discharge current) identical with the reference current Id of the overcurrent (pre-charge current or discharge current) is applied to the terminal 155) in the source driver circuit (IC) 14 of 8 bits, a state or a driving method thereof.

FIG. 406(a) shows the state of applying the overcurrent (pre-charge current or discharge current) Id. The overcurrent (pre-charge current or discharge current) Id is applied for a certain period, such as a 1/(2H) period of 1H. However, the 1/(2H) period of 1H is just an example, and it is not limited thereto. It goes without saying that it should desirably be configured to be switchable among the 1/(2H) period of 1H, 1/(4H) period of 1H, 2/(3H) period of 1H and 1/(8H) period of 1H. FIG. 406(b) shows the state after the application time of the overcurrent (pre-charge current or discharge current). FIG. 406(b) shows the output state of the program current Iw in the state in which the data D(D7 to D0) is “10000001,” that is, the D7 bit and D0 bit are in the on (closed) state by way of example.

As described above, in the embodiment of FIG. 406, the state of applying the overcurrent (pre-charge current or discharge current) Id is independent from the output state of the program current Iw.

FIG. 407(a) shows the state of applying the overcurrent (pre-charge current or discharge current) Id. The overcurrent (pre-charge current or discharge current) Id is applied for a certain period, such as a 1/(2H) period of 1H.

However, as explained in FIG. 406, the 1/(2H) period of 1H is just an example, and it is not limited thereto. It goes without saying that it should desirably be configured to be switchable among the 1/(2H) period of 1H, 1/(4H) period of 1H, 2/(3H) period of 1H and 1/(8H) period of 1H.

It goes without saying that the application time of the overcurrent (pre-charge current or discharge current) Id may be varied, changed or controlled according to the size of the video data, size of the sum total the video data of one screen, size of the potential of the source signal line 18 preceding by 1H, change in an image state of each frame and property of the image such as a still image or a dynamic image. Needless to say, the above can be applied to other embodiments herein.

In FIG. 407(a), all the switches D0 to D7 for generating the program current Iw are in the on (closed) state. For that reason, the overcurrent (pre-charge current or discharge current) outputted from the terminal 155 becomes the original overcurrent (pre-charge current or discharge current) Id plus the maximum program current Iw. It is possible, as described above, to apply the large overcurrent (pre-charge current or discharge current) Id to the source signal line 18 by controlling the switches D0 to D7 and Dc as in FIG. 407(a). For that reason, it is possible to reduce charge discharging time of the parasitic capacitance Cs.

FIG. 407(b) shows the state after the application time of the overcurrent (pre-charge current or discharge current). Similar to FIG. 406(b), FIG. 407(b) shows the output state of the program current Iw in the state in which the data D(D7 to D0) is “10000001,” that is, the D7 bit and D0 bit are in the on (closed) state by way of example.

As described above, it is possible, according to the embodiment of FIGS. 407, to apply the large overcurrent (pre-charge current or discharge current.) in the period for passing the overcurrent (pre-charge current or discharge current). In FIG. 407(a), it is not limited to turning on (closing) all the switches D0 to D7. It goes without saying that the on and off states of the switches D0 to D7 may be changed or controlled corresponding to the potential of the source signal line 18, length of the horizontal scanning period and size of the parasitic capacitance Cs.

In FIGS. 406 and 407, the overcurrent transistor 3861 is controlled, and the overcurrent (pre-charge current or discharge current) is applied to the source signal line 18. But the present invention is not limited to this. The embodiment is shown in FIG. 408.

In FIG. 408(a), all the switches D0 to D7 for generating the program current Iw are in the on (closed) state. However, the switches Dc for controlling the overcurrent transistors 3861 are in the open state. Therefore, Id which is the overcurrent (pre-charge current or discharge current) is not applied to the terminal 155. FIG. 408(a) is the embodiment generated by controlling the current of the program current Iw or more based on the video data and the switches D7 to D0. The shortage of writing generally occurs in the region of little video data (low gradation region). Therefore, the switch such as the bit D7 is not turned on in this region. The large program current (=overcurrent (pre-charge current or discharge current)) is generated by turning on the switch (such as D7) not to be turned on for this video data so as to control or manipulate the potential of the source signal line 18 with this current.

As described above, the overcurrent (pre-charge current or discharge current) outputted from the terminal 155 is the maximum program current Iw. It is possible, as described above, to apply the large overcurrent (pre-charge current or discharge current) Id to the source signal line 18 by controlling the switches D0 to D7 and Dc as in FIG. 408(a). For that reason, it is possible to reduce charge discharging time of the parasitic capacitance Cs.

FIG. 408(b) shows the state after the application time of the overcurrent (pre-charge current or discharge current). As with FIGS. 406(b) and 407(b), FIG. 408(b) shows the output state of the program current Iw (corresponding to the size of the normal video data) in the state in which the data D(D7 to D0) is “10000001, ” that is, the D7 bit and D0 bit are in the on (closed) state by way of example.

As described above, it is possible, according to the embodiment of FIGS. 408, to apply the large overcurrent (pre-charge current or discharge current) in the period for passing the overcurrent (pre-charge current or discharge current). In FIG. 408(a), it is not limited to turning on (closing) all the switches D0 to D7. It goes without saying that the on and off states of the switches D0 to D7 may be changed or controlled corresponding to the potential of the source signal line 18, length of the horizontal scanning period and size of the parasitic capacitance Cs.

The overcurrent transistors 3861 are provided in FIGS. 407. However, the present invention is not limited thereto. It is not necessary to form or place the overcurrent transistors 3861 as shown in FIGS. 470. In FIGS. 470, all the switches D0 to D7 are turned on to pass the maximum unitary current when applying the pre-charge current (FIG. 470(a)). When outputting the normal current, the switch D relevant to the video data is turned on as shown in FIGS. 470(b) (in FIGS. 470, at least the switch D1 is turned on, and the switches D0, D2 and D7 are open). The other configurations are described in the other embodiments, and so a description thereof will be omitted.

In FIGS. 407 and 470, all the switches D0 to D7 are closed when applying the pre-charge current. However, the present invention is not limited thereto. It is also possible to turn on only the D7 bit as a high-order bit when applying the pre-charge current. It is also possible to turn on the D4 to D7 bits falling under the high-order bits. To be more specific, according to the present invention, the switch Dn are manipulated so that the output current becomes larger than that when falling under predetermined video data.

In FIGS. 408(a) and 470(a), all the switches D0 to D7 for generating the program current Iw are in the on (closed) state. However, the switches Dc for controlling the overcurrent transistors 3861 are in the open state. Therefore, Id which is the overcurrent (pre-charge current or discharge current) is not applied to the terminal 155.

FIG. 408(a) is the embodiment generated by controlling the current of the program current Iw or more based on the video data and the switches D7 to D0. The shortage of writing generally occurs in the region of little video data (low gradation region). Therefore, the switch such as the bit D7 is not turned on in this region. The large program current (=overcurrent (pre-charge current or discharge current)) is generated by turning on the switch (such as D7) not to be turned on for this video data so as to control or manipulate the potential of the source signal line 18 with this current.

As described above, the overcurrent (pre-charge current or discharge current) outputted from the terminal 155 is the maximum program current Iw. It is possible, as described above, to apply the large overcurrent (pre-charge current or discharge current) Id to the source signal line 18 by controlling the switches D0 to D7 and Dc as in FIG. 408(a). For that reason, it is possible to reduce charge discharging time of the parasitic capacitance Cs.

FIG. 408(b) shows the state after the application time of the overcurrent (pre-charge current or discharge current). As with FIGS. 406(b) and 407(b), FIG. 408(b) shows the output state of the program current Iw (corresponding to the size of the normal video data) in the state in which the data D(D7 to D0) is “10000001,” that is, the D7 bit and D0 bit are in the on (closed) state by way of example.

As described above, it is possible, according to the embodiment of FIGS. 408, to apply the large overcurrent (pre-charge current or discharge current) in the period for passing the overcurrent (pre-charge current or discharge current). In FIG. 408(a), it is not limited to turning on (closing) all the switches D0 to D7. It goes without saying that the on and off states of the switches D0 to D7 may be changed or controlled corresponding to the potential of the source signal line 18, length of the horizontal scanning period and size of the parasitic capacitance Cs.

FIG. 399 and FIGS. 405 to 408 show the configuration or method of generating the overcurrent (pre-charge current or discharge current) Id in the direction for being absorbed from the terminal 155. The present invention is not limited to this. It may also be the configuration for discharging the overcurrent (pre-charge current or discharge current) from the terminal 155.

It goes without saying that it is possible to form, configure or place both the circuit for absorbing the overcurrent (pre-charge current or discharge current) from the terminal 155 and circuit for discharging the overcurrent (pre-charge current or discharge current) from the terminal 155.

FIG. 414 is the embodiment of the source driver circuit (IC) 14 of the present invention comprising both the circuit for absorbing the overcurrent (pre-charge current or discharge current) from the terminal 155 and circuit for discharging the overcurrent (pre-charge current or discharge current) from the terminal 155.

FIG. 414 is different from FIG. 399 and FIGS. 405 to 408 in that it has the circuit for discharging the overcurrent (pre-charge current or discharge current). The circuit for discharging the overcurrent (pre-charge current or discharge current) is comprised of the current mirror circuit consisting of a transistor 158d2 and the overcurrent transistor 3861. The overcurrent (pre-charge current or discharge current) Id2 (when the current mirror ratio is 1) is applied to the terminal 155 in the current mirror circuit.

In FIG. 414, a switch Dc2 is turned on in the case of applying the overcurrent (pre-charge current or discharge current) Id2 in the discharge direction to the terminal 155. The switch Dc1 is turned on in the case of applying the overcurrent (pre-charge current or discharge current) Id1 in the absorbing direction to the terminal 155. It is also possible to turn on the switches Dc1 and Dc2 simultaneously. The difference between the overcurrent (pre-charge current or discharge current) Id2 and the overcurrent (pre-charge current or discharge current) Id1 is applied to the terminal 155. Other configurations are not explained here since they are similar to those shown in FIGS. 399, 405 to 408.

In FIGS. 407, 408 and 470, the switches D0 to D7 (called the switches Dn) are controlled. A better image display can be implemented by controlling the period for turning on the switches Dn (pre-charge current application period). As shown in FIG. 471, the application time of the pre-charge current is implemented by controlling or manipulating the switches Dn. The period for turning on all the switches Dn is a period less than 1H. An on period data value as that period is held in an RAM 4712 by the controller circuit (IC) 760. The counter circuit 4682 is reset by the first main clock CLK of 1H, and is counted up by the CLK thereafter.

The count value of the counter circuit 4682 and the on period data held in the RAM 4712 are compared by a coincidence circuit 4711, and logic for turning on all the switches Dn is applied to the control circuit (not shown) of the switches Dn until they match so that the switches Dn are turned on. If the count value of the counter circuit 4682 matches with the on period data held in the RAM 4712, the coincidence circuit 4711 outputs the off voltage thereafter and only the switch of the switches Dn corresponding to the video data is turned on. It is easy to manipulate the switches Dn by performing masking in the logic circuit.

The operation for manipulating all the switches Dn and generating the pre-charge current is not performed to all the pixels. It goes without saying that it may or may not be performed depending on the potential change in the video signals, size of the video data and so on (referred to as adaptive pre-charge driving. Refer to FIGS. 417 to 422 and 463). The above is not explained here as it has been already explained in other embodiments of the present invention.

In the configurations of FIGS. 407, 408, 470 and 471, it is determined from the video data and so on in the first period of 1H (1 horizontal scanning period), the switch 151a is closed when necessary and the pre-charge voltage Vpc is applied to the terminal 155 and then to the source signal line 18. Basically, the switch 151a is controlled in the open state when the pre-charge voltage Vpc is applied.

It is determined from the video data and so on at the beginning of 1H or after applying the pre-charge voltage, the switches Dn are closed when necessary and the pre-charge voltage is applied to the terminal 155 and then to the source signal line 18. After applying the pre-charge voltage, the switch D relevant to the normal video data is closed and the program current Iw is applied to the source signal line 18.

In FIGS. 407, 408, 470 and 471, the longer the pre-charge current Id is applied, the larger the potential change in the source signal line 18 becomes. To be more specific, the potential change in the source signal line 18 can be rendered larger by controlling the period for applying the pre-charge current.

The period for applying the pre-charge current Id can be controlled just by the counter value as shown in FIG. 471. Basically, the pre-charge current Id has no temperature characteristic. As described in FIG. 380 (a), the period for charging and discharging the parasitic capacitance is linear. Therefore, it is easily controllable by the logic.

FIG. 472 shows the on time of all the switches Dn when changing to a next gradation n in the case where the applied potential of the source signal line is a gradation 0 voltage or a gradation 0 current (represented by the voltage as V0). For instance, all the switches Dn should be on for 2 (μsec) when changing to the 1^{st} gradation (0^{th} gradation to 1^{st} gradation). Similarly, for instance, all the switches Dn should be on for 4 (μsec) when changing to the 5^{th} gradation (0^{th} gradation to 5^{th} gradation). And similarly, for instance, all the switches Dn should be on for 6 (μsec) when changing to the 10^{th} gradation (0^{th} gradation to 10^{th} gradation). It is constant from the 20^{th} gradation onward, and all the switches Dn should be on for 8 (μsec). It is because the target potential of the source signal line 18 is reachable by the normal program current from the 20^{th} gradation onward.

In FIG. 472, the application time is stored in a matrix table according to the gradations (for instance, the on time of the switches Dn of gradation n against V0, on time of the switches Dn of gradation n against V1, on time of the switches Dn of gradation n against V2, . . . also refer to FIG. 463) by the controller circuit (IC) 760 so as to control the switches Dn according to this table. Needless to say, this may apply to other embodiments of the present invention.

FIGS. 407, 408, 470 and 471 have the configuration for generating the pre-charge current in the absorption current direction. The present invention is not limited to this. As shown in FIG. 473, it is possible, for instance, to form or configure a program current output stage 431ca of a sink current and a program current output stage 431cb for outputting the discharge current in the source driver circuit (IC) 14. In the case of generating the pre-charge current of the sink current, the switches Dn of the output stage 431ca are controlled or manipulated. In the case of generating the discharge current, the switches Dn of the output stage 431cb are controlled or manipulated. Either pre-charge current is implemented by controlling the switches 151b1 and 151b2.

According to the embodiments of the present invention, the voltage close to the anode voltage is applied as the pre-charge voltage Vpc. However, it is not limited thereto. It is also possible, for instance, to apply the pre-charge voltage Vpc as in FIGS. 474. FIG. 474(a) shows the embodiment for applying the pre-charge voltage Vpc=voltage V0 corresponding to gradation 0 in a first ta period of 1H at the low gradation. FIG. 474(b) shows the embodiment for applying the pre-charge voltage Vpc=voltage V255 corresponding to gradation 255 in the first ta period of 1H at the high gradation. In either case, the program current is applied after applying the pre-charge voltage Vpc.

It goes without saying that the pre-charge voltage Vpc may be applied not only for the predetermined period of 1H but also continuously for the 1H period. The embodiment is shown in FIG. 475.

FIG. 475(a) shows the embodiment for applying the pre-charge voltage Vpc=voltage V0 corresponding to gradation 0 in the 1H period at the low gradation. The voltage V0 is continuously applied as the pre-charge voltage for the period shown in (g). In the other periods, the pre-charge voltage Vpc is not applied and the driving is performed only by the program current. The program current operates relatively (changes from a present gradation to a next gradation).

FIG. 475(b) shows the embodiment for applying the pre-charge voltage Vpc=voltage V0 corresponding to gradation 0 in the 1H period at the low gradation, and applying the pre-charge voltage Vpc=voltage V255 corresponding to gradation 255 in the 1H period at the high gradation. The voltage V255 is continuously applied as the pre-charge voltage for the period shown in (e) Also, the voltage V0 is continuously applied as the pre-charge voltage for the period shown in (g). In the other periods, the pre-charge voltage Vpc is not applied and the driving is performed only by the program current. The program current operates relatively (changes from a present gradation to a next gradation).

FIGS. 403 are schematic diagrams to explain the drive method of the display panel (display apparatus) according to the present invention. FIGS. 403 show the states of the potential of the source signal line 18 according to the voltage pre-charge and program current. According to the embodiment of FIGS. 403, the pre-charge voltage generated by the source driver circuit (IC) 14 generates the potential V0 of gradation 0 (black voltage pre-charge) and the potential V255 of maximum gradation 255 (white voltage pre-charge).

In the case where the display panel is in a small size of 5 inches or less, it is possible to simplify the pre-charge voltage generation circuit. In FIG. 427, the number of generated pre-charge voltages is three (0 gradation: V0, 1 gradation: V1, 2 gradations: V2). FIG. 427 has the configuration combining FIGS. 351 to 353 and FIG. 309 and FIG. 310 or a similar configuration.

In FIG. 427, the voltage V0 is applied to a terminal 283b of the source driver circuit (IC) 14. The voltage V0 is configured to be set or adjusted freely by a regulator. It is possible, by adjusting the voltage V0, to implement an optimal black display on the EL display panel of the present invention. The voltage V2 is applied to an L terminal 283c. The voltage V2 is also configured to be set or adjusted by a regulator freely outside the source driver circuit (IC) 14. It is possible, by adjusting the voltages V0 and V2, to obtain the optimal black display and display of the 2^{nd} gradation on the EL display panel of the present invention. It goes without saying that the voltages V0 and V2 may be digitally changed or adjusted by forming or configuring the DA circuit inside the source driver circuit (IC) 14.

The pre-charge voltage V1 of the 1^{st} gradation is generated by the voltages V0, V2 and built-in or external resistors Ra and Rb. If the voltage V2 is changed, the voltage V1 also changes relatively. The reference current ratio control is implemented according to the present invention. If the reference current ratio is varied or changed, an operating point at each gradation (size of the program current) changes as described in FIGS. 355, 356 and 350. Therefore, even in the case of the same 2^{nd} gradation, the size of the program current becomes different and the potential of the source signal line 18 also becomes different if the reference current is changed.

In the configuration of FIG. 427, the voltage V2 is changed in conjunction with the reference current or the reference current ratio. Therefore, the voltage V1 also changes. As the voltage V0 which is the 0^{th} gradation is the operational origin, it does not need to be adjusted even if the reference current is changed. To be more specific, the present invention is the configuration or method capable of fixing the voltage V0 corresponding to the 0^{th} gradation (complete black display) and adjusting a higher gradation than the voltage V0 (the voltage V2 in the embodiment of FIG. 427) as required.

The voltage V0 is sufficiently practical even if it is common to the RGB. As for the voltage V2, however, it is necessary to set it individually such as the voltage V2 for R, the voltage V2 for G and the voltage V2 for B because the efficiency of the EL element 15 is different according to the RGB.

It is desirable to have the pre-charge voltage Vpc such as V0 work in conjunction with the anode voltage Vdd. The embodiment is shown in FIG. 521. The pre-charge voltage Vpc is basically the threshold voltage of the driving transistor 11a. The threshold voltage, that is, the anode voltage Vdd is the voltage of one terminal of the driving transistor 11a. Therefore, it is necessary, if the anode voltage Vdd becomes higher, to make the pre-charge voltage Vpc also higher. It is necessary, if the anode voltage Vdd becomes lower, to make the pre-charge voltage Vpc also lower.

As for the above problem, it is possible, as shown in FIG. 521, to render the power supply voltage of the electronic regulator 501 as the anode voltage Vdd so that the voltage Vpc changes in conjunction if the voltage Vdd changes. Therefore, it is possible to implement a good pre-charge.

According to the embodiment, the pre-charge voltage Vpc works in conjunction with the anode voltage Vdd. However, the present invention is not limited thereto. It may also work in conjunction with the cathode voltage depending on the pixel configuration and placement or polarity (P-channel or N-channel) of the driving transistor 11a. As described above, the present invention is characterized by having the cathode voltage or the anode voltage work in conjunction with the pre-charge voltage Vpc.

The voltages V0, V1 and V2 which are the pre-charge voltages are transmitted (conveyed) by the internal wiring in a longitudinal direction in the source driver circuit (IC) 14. The switch Sp is formed or placed at the intersection of the output wiring 150 of a current output stage 771 and the wiring having the pre-charge voltage applied thereto. Each switch is on-off controlled by an SSEL signal (2 bits). For instance, if a switch Sp1a is turned on, the voltage V0 is outputted from a terminal 2884a. Also, if a switch Sp2b is turned on, the voltage V1 is outputted from a terminal 2884b. Other configurations are not explained here as they are the same as or similar to those shown in FIGS. 351 to 353, 309, 310 or the like. The SSEL signal is generated in the controller IC (circuit) 760 and transmitted to the source driver circuit (IC) 14. The SSEL signal is determined and generated as to each video signal.

As shown in FIG. 350, the voltage V0 is the threshold voltage of the driving transistor 11a. Therefore, as for the pre-charge voltage, it is necessary to apply the voltage closer to the voltage Vdd than the voltage V0. However, there are variations in the voltage V0 depending on the process of the array. In general, it should be adjusted by the array or panel by using the regulator. However, adjusting it individually adds up to the cost. FIG. 519 shows the configuration as the method of solving this problem.

In FIG. 519, a capacitor electrode 5191 is formed on the source driver circuit (IC) 14 and the source signal lines 18 between the display areas. The capacitor electrode 5191 is placed or formed via the source signal lines 18 and an insulating film so as not to be connected DC-wise (refer to FIGS. 523). According to the embodiments of the present invention, the capacitor electrode 5191 is formed or placed on the source signal lines 18. However, it is not limited thereto. It may also be formed or placed in lower layers of the source signal lines 18. Furthermore, the capacitor electrode 5191 may take any configuration for electromagnetically coupling with the source signal lines 18. For instance, it may have the configuration forming or placing electrodes between adjacent source signal lines 18 and electromagnetically coupling them with the source signal line 18.

As described in FIG. 350, the good black display can be implemented if the gate potential of the driving transistor 11a of the P channel gets close to the anode voltage Vdd. The gate potential of the driving transistor 11a is the source signal line 18 on writing the program current Iw. Therefore, it is sufficient to be able to measure (meter or acquire) the potential of the source signal line 18 on the black display (black writing) for each array. The measured voltage is the voltage V0 or the voltages in proximity to it. This voltage changes on the array or the display panel.

It is configured as in FIG. 519, and the output of the source driver circuit (IC) 14 is set at 0. To be more specific, it is the black display because of the program current Iw=0. Then, the potential of the source signal line 18 also becomes the potential for implementing the black display. As the source signal lines 18 are connected to the capacitor electrode 5191 AC-wise (electromagnetically), the potential averaging the potentials of all the source signal lines (the source signal lines 18 overlapping (electromagnetically connected to) the capacitor electrode 5191) is induced to the capacitor electrode 5191. The induced potential is Vn. To stabilize this potential, the capacitor C may be connected as shown in FIG. 519.

The potential Vn of the capacitor electrode 5191 is converted to a digital signal by an analog-to-digital converter (AD converter) 5193 via a buffer 502. The Vn data converted to the digital signal is inputted to an adder 5192.

As the Vn data is the average of the potentials of the source signal lines 18 on the black display, it is in proximity to the voltage V0 and the complete black display cannot be expected at the voltage Vn. For that reason, it should be higher at the voltage Vdd than the voltage Vn by a predetermined value (the case where the driving transistor 11a is P-channel, whereas it is reverse in the case where the driving transistor 11a is N-channel). For that reason, as shown in FIG. 519, 8-bit data which is a constant voltage ADDV is added to the adder 5192. It is desirable to set the size of the ADDV data in the range of 0.05 to 0.2V. It is desirable to configure it variably as shown in FIG. 519. Variation is performed according to the lighting rate for instance.

The voltage wherein the ADDV and Vn data are added becomes the pre-charge voltage Vpc. The Vpc data is rendered as analog data by the electronic regulator 501 of the source driver circuit (IC) 14 so as to be applied as the pre-charge voltage to the pixels.

The embodiment of FIG. 519 is the method of detecting the potentials of the source signal lines 18. The method of FIGS. 520 has the configuration having a dummy pixel 5201 for detecting the voltage V0 formed or placed in a display area 144 or at a specific location of the display panel.

As shown in FIG. 520(a), the dummy pixel 5201 has the driving transistor 11a in the same size and form as the pixel 16 formed therein. As shown in FIG. 520(b), the dummy pixel 5201 is formed in a certain area of the display area 144. The driving transistor 11a of the dummy pixel 5201 has the gate and drain terminal shorted to be in the black display state.

As the transistor 11c closes, the gate terminal voltage of the driving transistor 11a is outputted. The outputted voltage Vn is converted to the digital signal by the analog-to-digital converter (AD converter) 5193. The Vn data converted to the digital signal is inputted to the adder 5192.

The Vn data is the gate terminal potential of the driving transistor 11a on the black display, and so it is in proximity to the voltage V0. However, the complete black display cannot be expected at the voltage Vn. For that reason, it should be higher at the voltage Vdd than the voltage Vn by a predetermined value (the case where the driving transistor 11a is P-channel, whereas it is reverse in the case where the driving transistor 11a is N-channel). For that reason, as shown in FIG. 520, similar to FIG. 519, 8-bit data which is a constant voltage ADDV is added to the adder 5192. It is desirable to set the size of the ADDV data in the range of 0.05 to 0.2V. It is desirable to configure it variably as shown in FIG. 520. Variation is performed according to the lighting rate for instance.

The voltage wherein the ADDV and Vn data are added becomes the pre-charge voltage Vpc. The Vpc data is rendered as analog data by the electronic regulator 501 of the source driver circuit (IC) 14 so as to be applied as the pre-charge voltage to the pixels.

According to the embodiment of FIG. 519, the voltage Vn is digitized and processed. However, the present invention is not limited thereto. It goes without saying that an addition and so on may be performed to the analog signal as-is.

FIG. 428 is a schematic diagram of the SSEL signal. As shown in FIG. 428, the switch Sp is not selected if SSEL=0. To be more specific, the pre-charge voltage Vpc (V0, V1, V2 in FIG. 427) is not applied. Therefore, the pre-charge voltage driving is not implemented to the source signal line 18. In the case of SSEL=1, the switch SP1 is selected and the voltage V0 is applied to the source signal line 18 for a predetermined period. After the pre-charge voltage Vpc=V0 is applied, the current driving is implemented. However, it is gradation 0 at V0 and so the program current Iw is also 0. In this case, the gate terminal potential of the driving transistor 11a of the pixel 16 changes so as not to pass the current. For that reason, the potential of the source signal line 18 changes even after applying the voltage V0.

In the case of SSEL=2, the switch SP2 is selected and the voltage V1 is applied to the source signal line 18 for a predetermined period. After the pre-charge voltage Vpc=V1 is applied, the current driving is implemented. Similarly, in the case of SSEL=3, the switch SP3 is selected and the voltage V2 is applied to the source signal line 18 for a predetermined period. After the pre-charge voltage Vpc=V2 is applied, the current driving is implemented.

The embodiment is the embodiment of the pre-charge voltage circuit. FIG. 429 is the embodiment of the pre-charge current circuit. The output voltage Va from the electronic regulator 501b is changed by IDATA. The voltage Va is applied to a positive terminal of the operational amplifier 502. The constant current circuits are configured by the operational amplifiers 502, transistors 158a and resistors R. The output current (pre-charge current) of each constant current circuit is changed (adjustable) by the values of the resistors R (Ra, Rb and Rc).

A pre-charge current I0 passes through the transistor 158a1. A pre-charge current I1 passes through the transistor 158a2. Similarly, a pre-charge current I2 passes through the transistor 158a2. It depends on the control exerted on the switch SP by the SSEL signal as to which pre-charge current is outputted to the terminal 2884.

FIG. 430 is a schematic diagram of the SSEL signal in FIG. 429. As shown in FIG. 430, the switch Sp is not selected if SSEL=0. To be more specific, the pre-charge current Ic (I0, I1, I2 in FIG. 429) is not applied. Therefore, the pre-charge current driving is not implemented to the source signal line 18. In the case of SSEL=1, the switch SP1 is selected and the current I0 is applied to the source signal line 18 for a predetermined period. After the pre-charge current I0 is applied, the current driving is implemented. However, it is gradation 0 and so the program current Iw is also 0. In this case, the gate terminal potential of the driving transistor 11a of the pixel 16 changes so as not to pass the current.

In the case of SSEL=2, the switch SP2 is selected and the current I1 is applied to the source signal line 18 for a predetermined period. After the pre-charge current Ic=I1 is applied, the program current driving is implemented. Similarly, in the case of SSEL=3, the switch SP2 is selected and the current I2 is applied to the source signal line 18 for a predetermined period. After the pre-charge current Ic=I1 is applied, the program current driving is implemented.

It goes without saying that the pre-charge voltage circuit of FIG. 427 may be combined with the pre-charge current circuit of FIG. 429.

In FIG. 403, the period for applying the pre-charge voltage is 1 μsec by way of example. Therefore, a current program period is 1H time−1 μsec. The present invention is not limited to this. It goes without saying that it may also be another configuration, state or time (refer to the embodiment in FIG. 471). The matters relating to the voltage driving or the pre-charge voltage driving and the current driving are described in FIG. 16, FIGS. 75 to 79, FIGS. 127 to 142, FIG. 213, FIG. 238, FIGS. 257 to 258, FIG. 263, FIGS. 293 to 297, FIGS. 308 to 313, FIGS. 331 to 349 and FIGS. 351 to 354. The matters described or listed in these drawings are relevant, correspondingly applicable or similar, and so descriptions thereof will be omitted.

The matters relating to the overcurrent (pre-charge current or discharge current) driving are described in FIGS. 381 to 422. The matters described or listed in these drawings are relevant, correspondingly applicable or similar, and so descriptions thereof will be omitted. The above matters are also applicable to the other embodiments of the present invention. They may also be mutually combined.

The embodiment in FIGS. 403 will be described on condition that each of the RGB is 8 bits (125-gradation display). As previously described, the present invention is not limited to the RGB. It may also be monochromatic, or cyan, yellow or magenta, or may be four colors of the RGB plus W (white). FIG. 403(a) is the embodiment for changing from gradation 0 to gradation 255. When the potential difference between gradation 0 and gradation 255 is large, a white voltage pre-charge (applying the voltage V255) is implemented. As shown in FIG. 403(a), the white voltage pre-charge is implemented in the period from the first period of 1H (not limited to the first period of 1H) to 1 μsec. The voltage is applied to the source signal line 18 by implementing the white voltage pre-charge so that the potential of the source signal line 18 becomes V255. Thereafter, the current program is implemented, and the potential of the source signal line 18 is corrected according to the characteristics of the driving transistor 11a of the pixel 16. In FIG. 403(a), the potential of the source signal line 18 rises in the direction of the anode voltage Vdd by way of example.

FIG. 403(b) is the embodiment for changing from gradation 255 to gradation 0. When the potential difference between gradation 255 and gradation 0 is large, a black voltage pre-charge (applying the voltage V0) is implemented. As shown in FIG. 403(b), the black voltage pre-charge is implemented in the period from the first period of 1H (not limited to the first period of 1H) to 1 μsec. The black voltage pre-charge is implemented and the voltage V0 is thereby applied to the source signal line 18 so that the potential of the source signal line 18 becomes V0 which is close to the GND voltage. Thereafter, the current program is implemented, and the potential of the source signal line 18 is corrected according to the characteristics of the driving transistor 11a of the pixel 16 so as to pass the current equal to the target program current. In FIG. 403(b), the potential of the source signal line 18 declines in the direction of the GND potential by way of example.

FIG. 403(c) is the embodiment for changing from gradation 0 to gradation 200. When the potential difference between gradation 0 and gradation 200 is relatively large, a white voltage pre-charge (applying the voltage V255) is implemented. The black voltage pre-charge is implemented when changing to the gradation region lower than ¼ of the entire gradations. The white voltage pre-charge is implemented when changing to the gradation region higher than ½ of the entire gradations. As shown in FIG. 403(c), the white voltage pre-charge is implemented in the period from the first period of 1H (not limited to the first period of 1H) to 1 μsec. The voltage is applied to the source signal line 18 by implementing the white voltage pre-charge so that the potential of the source signal line 18 becomes V255. Thereafter, the current program is implemented, and the driving transistor 11a of the pixel 16 operates mainly so as to be corrected by the potential of the source signal line 18 equivalent to a target gradation current 200.

FIGS. 404 are schematic diagrams of a driving method of implementing b0^{th} the overcurrent driving (pre-charge current driving) and the voltage driving (pre-charge voltage driving). The circuit configuration is the configuration of FIG. 405 by way of example. The switches 151 are in the closed state when they are on, and are in the open state when they are off. When the switch 151a is on, the pre-charge voltage Vpc is applied to the terminal 155 (applied to the source signal line 18). When the switch 151b is on, the program current Iw is applied to the terminal 155 (applied to the source signal line 18). When the switch Dc is on, the overcurrent (pre-charge current or discharge current) Id is applied to the terminal 155 (applied to the source signal line 18).

As shown in FIG. 40A(a), there is no operational problem even if there simultaneously occur the state in which the switch 151a is on and the pre-charge voltage Vpc is applied to the terminal 155 and the state in which the switch 151b is on and the program current Iw is applied to the terminal 155. It is because the constant current circuit 431c has high internal impedance and is capable of normal operation even if shorted with a constant-voltage circuit (pre-charge voltage circuit) As shown in FIG. 404(b) and (c), however, it is desirable to put the switch 151a in the off state when the switch Dc is in the on state. It is because there are the cases where the current from the overcurrent (pre-charge current or discharge current) circuit flows as a rush current to the constant-voltage circuit. As shown in FIG. 404(a), there is no problem if the switch 151a in the on state when the switch Dc is in the off state.

As shown in FIGS. 404(b) and (c), it is possible, by controlling the period in which the switch Dc is on, to adjust the period in which the overcurrent (pre-charge current or discharge current) is applied to the terminal 155. In FIG. 404(b), the period in which the overcurrent (pre-charge current or discharge current) is applied is 1/(3H). In FIG. 404(c), the period in which the overcurrent (pre-charge current or discharge current) is applied is 1/(4H). FIG. 404(c) can render the potential change of the source signal line 18 larger than FIG. 404(b).

FIGS. 407 and 408 described the configuration for manipulating the switches D0 to D7 controlling the program current Iw. FIGS. 409 show a further detailed embodiment or an other embodiment.

As for the switch Dc for passing the overcurrent (pre-charge current or discharge current), it is possible to control the period to be on by the on-off signal applied to the internal wiring 150b. According to the embodiment of FIGS. 409, it is controllable by four periods of 0, ¼, 2/4 and 3/4 of 1H. Likewise, it is possible, according to the embodiment of FIGS. 409, to control the period for manipulating (controlling) the switches D0 to D7 forcibly controlling the program current Iw (described as forcible control) by the four periods of 0, ¼, 2/4 and 3/4 of 1H. In FIGS. 409, the period for passing the normal current is described as data control and also described as gradations 4 to 5 (described as 4→5). According to the embodiment of FIGS. 409, at least the period of ½ of 1H is the period for passing the normal program current.

The period for passing the normal program current (the state in which the switches D0 to D7 relevant to the video signals are set (manipulated or controlled) to be the normal program current) may be the entire 1H period. To be more specific, it may be any period from 1/(4H) to 1H.

The switch Dc is manipulated (controlled) and the switches D0 to D7 are forcibly manipulated (controlled) according to the change in the gradation. As for the manipulation (control) of the switch Dc and the forcible manipulation (control) of the switches D0 to D7, a determination is made by the controller circuit (IC) 760 based on the change in the video signal by 1H or the change in or change ratio of the video signal in 1F (1 frame). Determined data or control signals are converted to the differential signals, and are transmitted to the source driver circuit (IC) 14.

In FIG. 409(a), the switch Dc for passing the overcurrent (pre-charge current or discharge current) is on (closed) for the period of 1/(4H) from the beginning of 1H. Therefore, the overcurrent (pre-charge current) is applied to the source signal line 18 for the period of 1/(4H) from the beginning of 1H. The switches D0 to D7 for passing the program current is forcibly (closed) for the period of 1/(2H) from the beginning of 1H. Therefore, the pre-charge current from the switches D0 to D7 is applied to the source signal line 18 for the period of 1/(2H) from the beginning of 1H by being added to the overcurrent (pre-charge current or discharge current) Id passed by the operation of the switch Dc.

The period for adding to the overcurrent (pre-charge current or discharge current) Id is the period of 1/(4H) from the beginning of 1H, which is relatively short. The period for passing the normal program current (the state in which the switches D0 to D7 relevant to the video signals are set (manipulated or controlled) to be the normal program current) is implemented in the second 1/(2H) period of 1H. The potential of the source signal line 18 is changed from a gradation 4 level to gradation 5 level in the period of 1/(2H) from the beginning of 1H by the above operation. And the current program is implemented so that the driving transistor 11a of the pixel 16 passes the target program current Iw after being corrected by the normal program current in the second 1/(2H) period of 1H.

In FIG. 409(b), the switch Dc for passing the overcurrent (pre-charge current or discharge current) is on (closed) for the period of 1/(2H) from the beginning of 1H. Therefore, the overcurrent (pre-charge current) is applied to the source signal line 18 for the period of 1/(2H) from the beginning of 1H. The switches D0 to D7 for passing the program current is forcibly (closed) for the period of 1/(2H) from the beginning of 1H. Therefore, the pre-charge current from the switches D0 to D7 is applied to the source signal line 18 for the period of 1/(2H) from the beginning of 1H by being added to the overcurrent (pre-charge current or discharge current) Id passed by the operation of the switch Dc.

The period for passing the normal program current (the state in which the switches D0 to D7 relevant to the video signals are set (manipulated or controlled) to be the normal program current) is implemented in the second 1/(2H) period of 1H.

The potential of the source signal line 18 is changed from a gradation 1 level to gradation 2 level in the period of 1/(2H) from the beginning of 1H by the above operation. And the current program is implemented so that the driving transistor 11a of the pixel 16 passes the target program current Iw after being corrected by the normal program current in the second 1/(2H) period of 1H. As described above, when the potential of the source signal line 18 starting the operation is at a gradation 1 level, it is necessary to extend the period for keeping the switch Dc on so as to apply the overcurrent (pre-charge current or discharge current) Id to the source signal line 18 for a long time.

In FIG. 409(c), the switch Dc for passing the overcurrent (pre-charge current or discharge current) is on (closed) for the period of 3/(4H) from the beginning of 1H. Therefore, the overcurrent (pre-charge current) is applied to the source signal line 18 for the period of 3/(4H) from the beginning of 1H. The switches D0 to D7 for passing the program current is forcibly (closed) for the period of 1/(4H) from the beginning of 1H. Therefore, the pre-charge current from the switches D0 to D7 is applied to the source signal line 18 for the period of 1/(4H) from the beginning of 1H by being added to the overcurrent (pre-charge current or discharge current) Id passed by the operation of the switch Dc.

The period for passing the normal program current (the state in which the switches D0 to D7 relevant to the video signals are set (manipulated or controlled) to be the normal program current) is implemented in the second 1/(4H) period of 1H.

The potential of the source signal line 18 is changed from a gradation 0 level to gradation 1 level in the period of 3/(4H) from the beginning of 1H by the above operation. And the current program is implemented so that the driving transistor 11a of the pixel 16 passes the target program current Iw after being corrected by the normal program current in the second 1/(4H) period of 1H. As described above, when the potential of the source signal line 18 starting the operation is at a gradation 0 level, it is necessary to extend the period as long as possible for keeping the switch Dc on so as to apply the overcurrent (pre-charge current or discharge current) Id to the source signal line 18 for a long time.

In FIG. 409(d), the switch Dc for passing the overcurrent (pre-charge current or discharge current) does not operate. The switches D0 to D7 for passing the program current is forcibly (closed) for the period of 1/(2H) from the beginning of 1H. Therefore, the pre-charge current from the switches D0 to D7 is applied to the source signal line 18 for the period of 1/(2H) from the beginning of 1H by being added to the overcurrent (pre-charge current or discharge current) Id passed by the operation of the switch Dc.

The period for passing the normal program current (the state in which the switches D0 to D7 relevant to the video signals are set (manipulated or controlled) to be the normal program current) is implemented in the second 1/(2H) period of 1H. The potential of the source signal line 18 is changed from a gradation 0 level to gradation 1 level in the period of 1/(2H) from the beginning of 1H by the above operation. And the current program is implemented so that the driving transistor 11a of the pixel 16 passes the target program current Iw after being corrected by the normal program current in the second 1/(2H) period of 1H. As described above, the switch Dc for passing the overcurrent (pre-charge current or discharge current) is not operated because the gradation change is relatively large as to the gradations before the change (the potential of the source signal line 18 is high), and the change is relatively small as to the 16^{th} to 18^{th} gradations.

The embodiment continuously keeps the switch Dc in the on state. However, the present invention is not limited thereto. In FIG. 409(e), the switch Dc is kept in the on state for the 1H period. However, the present invention is not limited thereto. FIG. 409(e) shows the embodiment in which the switch Dc is turned on multiple times (twice) in the 1H period. In FIG. 409(e), the switch Dc for passing the overcurrent (pre-charge current or discharge current) is on (closed) for the period of 1/(4H) from the beginning of 1H and for the period of 1/(4H) after elapse of 1/(2H). Therefore, the overcurrent (pre-charge current) is applied to the source signal line 18 for the period of 1/(2H) of 1H as a whole. The switches D0 to D7 for passing the program current is forcibly (closed) for the period of 1/(2H) from the beginning of 1H.

Therefore, the pre-charge current from the switches D0 to D7 is applied to the source signal line 18 for the period of 1/(4H) from the beginning of 1H by being added to the overcurrent (pre-charge current or discharge current) Id passed by the operation of the switch Dc. The period for passing the normal program current (the state in which the switches D0 to D7 relevant to the video signals are set (manipulated or controlled) to be the normal program current) is implemented in the second 1/(4H) period of 1H.

The potential of the source signal line 18 is changed from a gradation 2 level to gradation 3 level in the period of 3/(4H) from the beginning of 1H by the above operation. And the current program is implemented so that the driving transistor 11a of the pixel 16 passes the target program current Iw after being corrected by the normal program current in the second 1/(4H) period of 1H. As described above, the constant current can be added in the current driving. Therefore, the overcurrent (pre-charge current or discharge current) Id may be added in any period other than the second half (other than the last) of 1H. It may also be applied by being divided into multiple times. It goes without saying that the above is also applicable to the forcible control of the switches D0 to D7.

According to the above embodiment, the switch Dc is in the on state from the beginning of 1H. However, the present invention is not limited thereto. FIG. 409(f) shows the embodiment in which the switch Dc is turned on after elapse of 1/(4H) period from the beginning. Furthermore, the switches D0 to D7 for passing the program current is forcibly (closed) for the period of 3/(4H) from the beginning of 1H.

Therefore, the pre-charge current from the switches D0 to D7 is applied to the source signal line 18 for the period of 1/(4H) from the beginning of 1H by being added to the overcurrent (pre-charge current or discharge current) Id passed by the operation of the switch Dc.

The period for passing the normal program current (the state in which the switches D0 to D7 relevant to the video signals are set (manipulated or controlled) to be the normal program current) is implemented in the second 1/(4H) period of 1H. The potential of the source signal line 18 is changed from a gradation 5 level to gradation 6 level in the period of 3/(4H) from the beginning of 1H by the above operation. And the current program is implemented so that the driving transistor 11a of the pixel 16 passes the target program current Iw after being corrected by the normal program current in the second 1/(4H) period of 1H. As described above, the constant current can be added in the current driving. Therefore, the overcurrent (pre-charge current or discharge current) Id does not always have to be applied from the beginning of 1H. It may be applied in any period other than the second half (other than the last) of 1H. It may also be applied by being divided into multiple times. It goes without saying that the above is also applicable to the forcible control of the switches D0 to D7.

According to the above embodiment, the control period or manipulation period is 1H. However, the present invention is not limited thereto. It goes without saying that it may be implemented in a specific period over 1H. It also goes without saying that it may be implemented by combining the overcurrent (pre-charge current or discharge current) driving with the pre-charge voltage (program voltage) driving. Needless to say, this can be applied to other embodiments according to the present invention.

FIGS. 410 show the embodiment combining the overcurrent (pre-charge current or discharge current) driving with the pre-charge voltage (program voltage) driving. It is also the embodiment having changed the overcurrent (pre-charge current or discharge current) Id application period.

FIGS. 410 show the cases where the pre-charge voltage is the voltage V0 corresponding to 0 gradation. First, FIGS. 410(a1), (a2) and (a3) will be described. In FIG. 410(a1), the pre-charge voltage is applied for 1 μsec at the beginning of 1H. As shown in FIG. 410(a2), the overcurrent (pre-charge current or discharge current) Id is applied to the source signal line 18 for the period of 1/(2H) from the beginning of 1H. Therefore, as shown in FIGS. 410(a3), the potential of the source signal line 18 is a voltage potential V0 of 0 gradation in the period from t1 to t0. In the period from t0 to t3, the potential of the source signal line 18 lowers due to the overcurrent (pre-charge current or discharge current) Id (the absorption current direction). The current program on the video data is implemented in the period from t3 to t2 (the end of 1H).

Therefore, the potential of the source signal line 18 lowers so as to pass the current matching with the program current through the driving transistor 11a of the pixel 16. According to the embodiment of FIGS. 410 (a), the potential of the source signal line 18 is set at a predetermined value by applying the pre-charge voltage V0, and then the current pre-charge by the overcurrent (pre-charge current or discharge current) Id is implemented. Therefore, it is easy to theoretically estimate the proper size of the overcurrent (pre-charge current or discharge current) Id and the application time of the overcurrent (pre-charge current or discharge current) so as to have them controlled or set by the controller circuit (IC) 760. For that reason, it is possible to implement a good and accurate current program.

Next, the driving method according to another embodiment of the present invention will be described by using FIGS. 410(b1), (b2) and (b3). In FIG. 410(b1), the pre-charge voltage is applied for the time of tx μsec from the beginning of 1H. As shown in FIG. 410(b2), the overcurrent (pre-charge current or discharge current) Id is applied to the source signal line 18 for the period of 1/(2H) from the beginning of 1H. Therefore, as shown in FIGS. 410(b3), the potential of the source signal line 18 is a voltage potential V0 of 0 gradation in the period from t1 to t0. Furthermore, in the period from t0 to t3, the potential of the source signal line 18 lowers due to the overcurrent (pre-charge current or discharge current) Id (the absorption current direction) The current program on the video data is implemented in the period from t3 to t2 (the end of 1H). Therefore, the potential of the source signal line 18 lowers so as to pass the current matching with the program current through the driving transistor 11a of the pixel 16.

According to the embodiment of FIGS. 410(b), it is possible, by controlling the period tx for applying the pre-charge voltage V0, to adjust the application period of the current pre-charge by the overcurrent (pre-charge current or discharge current) Id. Therefore, it is easy to theoretically estimate the proper size of the overcurrent (pre-charge current or discharge current) Id and the application time of the overcurrent (pre-charge current or discharge current) so as to have them controlled or set by the controller circuit (IC) 760. For that reason, it is possible to implement a good and accurate current program.

FIG. 410(a) and (b) are the cases of applying the pre-charge voltage once. However, the present invention does not limit the period for applying the pre-charge voltage to once. It is because the application of the pre-charge voltage allows the potential of the source signal line 18 to be reset, which facilitates potential control (adjustment) of the source signal line 18 by the overcurrent (pre-charge current or discharge current) Id driving. The pre-charge voltage Vpc is not limited to the voltage V0. As for the pre-charge voltage (synonymous with or similar to the program voltage), a wide variety of voltages can be set as described in FIGS. 127 to 143, FIG. 293, FIG. 311, FIG. 312 and FIGS. 339 to 344.

FIGS. 410(c1), (c2) and (c3) show the embodiment in which the pre-charge voltage is applied to the source signal line 18 multiple times in the 1H period (at predetermined time intervals). In FIG. 410(c1), the pre-charge voltage is applied for 1 μsec twice, that is, from the beginning of 1H and from the time t3. As shown in FIG. 410(c2), the overcurrent (pre-charge current or discharge current) Id is applied to the source signal line 18 for the period of 4/(5H) from the beginning of 1H. Therefore, as shown in FIGS. 410(c3), the potential of the source signal line 18 is a voltage potential V0 of 0 gradation in the period from t1 to t0. In the period from t0 to t3, the potential of the source signal line 18 lowers due to the overcurrent (pre-charge current or discharge current) Id. In the period of t3 to t4, however, the potential of the source signal line 18 is reset to V0 in order to apply the pre-charge voltage. In the period from t4 to t5, the potential of the source signal line 18 lowers again due to the overcurrent (pre-charge current or discharge current) Id. The current program on the video data is implemented in the period from t5 to t2 (the end of 1H). Therefore, the potential of the source signal line 18 lowers so as to pass the current matching with the program current through the driving transistor 11a of the pixel 16.

According to the embodiment of FIGS. 410(c), the potential of the source signal line 18 is reset to the predetermined value by applying the pre-charge voltage V0, and the operation of the current program is started from the time when the last pre-charge voltage is applied. Therefore, it is possible, by controlling or adjusting the timing for applying the pre-charge voltage, to theoretically control the proper size of the overcurrent (pre-charge current or discharge current) Id and the application time of the overcurrent (pre-charge current or discharge current). Therefore, it is easy to control or set it with the controller circuit (IC) 760 (not shown) so as to implement the good and accurate current program.

FIGS. 410 showed the embodiment in which the constant pre-charge voltage (program voltage) is applied. FIGS. 411 show the embodiment in which the pre-charge voltage is changed. By way of example, the overcurrent (pre-charge current or discharge current) Id in FIGS. 411 is applied for the period of 1/(2H) from the beginning of 1H (period t1 to t3).

FIG. 411(a1) is the case where the pre-charge voltage is the voltage V0 corresponding to gradation 0. FIG. 411(b1) is the case where the pre-charge voltage is the voltage V1 corresponding to gradation 1. FIG. 411(c1) is the case where the pre-charge voltage is the voltage V2 corresponding to gradation 2.

FIGS. 411(a1), (a2) and (a3) will be described. In FIG. 411(a1), the pre-charge voltage V0 is applied for 1 μsec at the beginning of 1H. As shown in FIG. 411(a2), the overcurrent (pre-charge current or discharge current) Id is applied to the source signal line 18 for the period of 1/(2H) from the beginning of 1H. Therefore, as shown in FIGS. 411(a3), the potential of the source signal line 18 is a voltage potential V0 of 0 gradation in the period from t1 to t0.

In the period from t0 to t3, the potential of the source signal line 18 lowers due to the overcurrent (pre-charge current or discharge current) Id (the absorption current direction). The current program on the video data is implemented in the period from t3 to t2 (the end of 1H). Therefore, the potential of the source signal line 18 lowers so as to pass the current matching with the program current through the driving transistor 11a of the pixel 16.

According to the embodiment of FIGS. 411(a), the potential of the source signal line 18 is set at a predetermined value by applying the pre-charge voltage V0, and then the current pre-charge by the overcurrent (pre-charge current or discharge current) Id is implemented. Therefore, it is easy to theoretically estimate the proper size of the overcurrent (pre-charge current or discharge current) Id and the application time of the overcurrent (pre-charge current or discharge current) so as to have them controlled or set by the controller circuit (IC) 760. For that reason, it is possible to implement a good and accurate current program.

Next, FIGS. 411(b1), (b2) and (b3) will be described. In FIG. 411(b1), the pre-charge voltage V1 corresponding to the 1^{st} gradation is applied for 1 μsec at the beginning of 1H. As shown in FIG. 411(b2), the overcurrent (pre-charge current or discharge current) Id is applied to the source signal line 18 for the period of 1/ (2H) from the beginning of 1H. Therefore, as shown in FIGS. 411(b3), the potential of the source signal line 18 is a voltage potential V1 of 1 gradation in the period from t1 to t0. In the period from t0 to t3, the potential of the source signal line 18 lowers due to the overcurrent (pre-charge current or discharge current) Id (the absorption current direction). The current program on the video data is implemented in the period from t3 to t2 (the end of 1H). Therefore, the potential of the source signal line 18 lowers so as to pass the current matching with the program current through the driving transistor 11a of the pixel 16.

According to the embodiment of FIGS. 411(b), the potential of the source signal line 18 is set at a predetermined value by applying the pre-charge voltage V1, and then the current pre-charge by the overcurrent (pre-charge current or discharge current) Id is implemented. The pre-charge voltage V1 has a lower potential to be written to the source signal line 18 than V0. The application time of the overcurrent (pre-charge current) is fixed, and the size of the overcurrent (pre-charge current or discharge current) Id is also fixed at Id0. Therefore, it is possible to render the potential of the source signal line 18 lower than FIGS. 411(a) so as to implement a higher luminance display.

Also, it is easy to theoretically estimate the proper size of the overcurrent (pre-charge current or discharge current) Id and the application time of the overcurrent (pre-charge current or discharge current) so as to have them controlled or set by the controller circuit (IC) 760. For that reason, it is possible to implement a good and accurate current program.

Furthermore, FIGS. 411(c1), (c2) and (c3) will be described. In FIG. 411(c1), the pre-charge voltage V2 corresponding to the 2^{nd} gradation is applied for 1 μsec at the beginning of 1H. As shown in FIG. 411(c2), the overcurrent (pre-charge current or discharge current) Id is applied to the source signal line 18 for the period of 1/(2H) from the beginning of 1H. Therefore, as shown in FIGS. 411(c3), the potential of the source signal line 18 is a voltage potential V2 of 2^{nd} gradation in the period from t1 to t0.

Furthermore, in the period from t0 to t3, the potential of the source signal line 18 lowers due to the overcurrent (pre-charge current or discharge current) Id (the absorption current direction). The current program on the video data is implemented in the period from t3 to t2 (the end of 1H). Therefore, the potential of the source signal line 18 lowers so as to pass the current matching with the program current through the driving transistor 11a of the pixel 16.

According to the embodiment of FIGS. 411(c), the potential of the source signal line 18 is set at a predetermined value by applying the pre-charge voltage V2, and then the current pre-charge by the overcurrent (pre-charge current or discharge current) Id is implemented. The pre-charge voltage V2 has a far lower potential to be written to the source signal line 18 than V1. The application time of the overcurrent (pre-charge current) is fixed, and the size of the overcurrent (pre-charge current or discharge current) Id is also fixed at Id0. Therefore, it is possible to render the potential of the source signal line 18 lower than FIGS. 411(b) so as to implement a higher luminance display.

Also, it is easy to theoretically estimate the proper size of the overcurrent (pre-charge current or discharge current) Id and the application time of the overcurrent (pre-charge current or discharge current) so as to have them controlled or set by the controller circuit (IC) 760. For that reason, it is possible to implement a good and accurate current program.

As described above, it is possible to control the potential of the source signal line 18 easily when 1H passes by changing the size or potential of the pre-charge voltage Vpc.

FIGS. 411 showed the embodiment in which the constant pre-charge voltage (program voltage) is changed. FIGS. 412 show the embodiment in which the overcurrent (pre-charge current) is changed. It is possible to implement the change in the pre-charge current by controlling the DC0 and Dc1 switches and so on in FIGS. 392, 393 and 394. In FIGS. 412(a1) and (b1), the pre-charge voltage is fixed at V0. FIG. 412(c1) shows the embodiment in which no pre-charge voltage is applied.

FIGS. 412(a1), (a2) and (a3) will be described. In FIG. 412(a1), the pre-charge voltage V0 is applied for 1 μsec (the period of t1 to t0) at the beginning of 1H. As shown in FIG. 412(a2), the overcurrent (pre-charge current or discharge current) Id0 is applied to the source signal line 18 for the period of (t1) to t4 at the beginning of 1H. The overcurrent (pre-charge current or discharge current) Id1 is applied to the source signal line 18 for the period of t4 to t3.

As shown in FIGS. 412(a3), the potential of the source signal line 18 is a voltage potential V0 of 0 gradation in the period from t1 to t0. In the period of t0 to t4, the potential of the source signal line 18 drastically drops due to the large overcurrent (pre-charge current or discharge current) Id0 (the absorption current direction). In the period of t4 to t3, the potential of the source signal line 18 drops relatively gently due to the overcurrent (pre-charge current or discharge current) Id1 (the absorption current direction) smaller than the overcurrent (pre-charge current or discharge current) Id0. The current program on the video data is implemented in the period from t3 to t2 (the end of 1H). Therefore, the potential of the source signal line 18 lowers so as to pass the current matching with the program current through the driving transistor 11a of the pixel 16.

In the embodiment of FIGS. 412(a), the pre-charge voltage V0 is applied to set the potential of the source signal line 18 at the predetermined value, and then the current pre-charge is implemented first by the first overcurrent (pre-charge current or discharge current) Id0 so as to suddenly change the potential of the source signal line. Next, the current pre-charge is implemented by the second overcurrent (pre-charge current or discharge current) Id1 so as to bring the potential of the source signal line close to the target potential. Lastly, the current program is implemented so that the driving transistor 11a passes the predetermined current with the program current relevant to a target video signal. As described above, it is possible, by using multiple overcurrents (pre-charge currents or discharge currents) Id for control, to adjust the size and application time of the overcurrents (pre-charge currents or discharge currents) so as to implement the good and accurate current program.

It is also possible to theoretically estimate or speculate the potential change of the source signal line 18 so that it is easy to control or set it with the controller circuit (IC) 760 (not shown in drawings). For that reason, it is possible to implement a good and accurate current program.

Next, FIGS. 412(b1), (b2) and (b3) will be described. In FIG. 412 (b1), the pre-charge voltage V0 is applied for 1 μsec (the period of t1 to t0) at the beginning of 1H. As shown in FIG. 412(b2), the overcurrent (pre-charge current or discharge current) Id1 is applied to the source signal line 18 for the period of (t1) to t3 at the beginning of 1H.

As shown in FIG. 412(b3), the potential of the source signal line 18 is a voltage potential V0 of 0 gradation in the period from t1 to t0. Furthermore, in the period from t0 to t3, the potential of the source signal line 18 lowers due to the overcurrent (pre-charge current or discharge current) Id1 (the absorption current direction). The current program on the video data is implemented in the period from t3 to t2. Therefore, the potential of the source signal line 18 lowers so as to pass the current matching with the program current through the driving transistor 11a of the pixel 16.

According to the embodiment of FIGS. 412(b), the potential of the source signal line 18 is set at the predetermined value by applying the pre-charge voltage V0, and then the current pre-charge is implemented by the relatively small overcurrent (pre-charge current or discharge current) Id1 so as to change the potential of the source signal line. Lastly, the current program is implemented so that the driving transistor 11a passes the predetermined current with the program current relevant to the target video signal.

As described above, it is possible, by using the overcurrent (pre-charge current or discharge current) Id of a proper size for control from the target program current or the potential of the source signal line 18, to adjust the application time of the overcurrents (pre-charge currents or discharge currents) so as to implement the accurate current program. It is also possible to theoretically estimate or speculate the potential change of the source signal line 18 so that it is easy to control or set it with the controller circuit (IC) 760 (not shown in drawings). For that reason, it is possible to implement a good and accurate current program.

Furthermore, FIGS. 412(c1), (c2) and (c3) will be described. In FIG. 412(c1), no pre-charge current is applied. Therefore, the potential of the source signal line 18 is the potential preceding by 1H. Furthermore, as shown in FIG. 412(c2), the second overcurrent (pre-charge current or discharge current) Id1 is applied to the source signal line 18 for the period of (t1) to t4 at the beginning of 1H. The second overcurrent (pre-charge current or discharge current) Id0 is applied to the source signal line 18 for the period of t4 to t3.

As shown in FIG. 412(c3), the potential of the source signal line 18 is changed by the relatively small overcurrent (pre-charge current or discharge current) Id1 (the absorption current direction) in the period of t0 to t4. In the period of t4 to t3, the potential of the source signal line 18 drops drastically due to the overcurrent (pre-charge current or discharge current) Id0 (the absorption current direction) bigger than the overcurrent (pre-charge current or discharge current) Id1. Therefore, the potential of the source signal line 18 lowers so as to pass the current matching with the program current through the driving transistor 11a of the pixel 16.

According to the embodiment of FIGS. 412(c), the current pre-charge is implemented first by the second overcurrent (pre-charge current or discharge current) Id1 so as to change the potential of the source signal line. Next, the current pre-charge is implemented by the first overcurrent (pre-charge current or discharge current) Id0 so as to bring the potential of the source signal line close to the target potential. Lastly, the current program is implemented so that the driving transistor 11a passes the predetermined current with the program current relevant to the target video signal.

As described above, it is possible, by using multiple overcurrents (pre-charge currents or discharge currents) Id for control, to adjust the size and application time of the overcurrents (pre-charge currents or discharge currents) so as to implement the good and accurate current program. As the pre-charge voltage is not applied, it is possible to relatively change the potential from the potential applied to a preceding pixel line. It is possible to theoretically estimate or speculate the potential of the source signal line 18 applied to the preceding pixel line. It is easily controllable or settable by the controller circuit (IC) 760 (not shown in drawings). For that reason, it is possible to implement a good and accurate current program.

In FIGS. 412, the overcurrent (pre-charge current or discharge current) (pre-charge current) is changed in the 1H period (predetermined period). However, the present invention is not limited thereto. For instance, it is also possible to change the pre-charge voltage in the 1H period (predetermined period). It goes without saying that it is feasible to change the size of both the pre-charge current and pre-charge voltage. It also goes without saying that it is feasible to change the application time of both the pre-charge current and pre-charge voltage.

FIGS. 413 show the embodiment in which the timing for applying the pre-charge voltage is changed. The overcurrent (pre-charge current) is the same. In FIGS. 412(a1), (b1) and (c1), the pre-charge voltage is fixed at V0.

FIGS. 413(a1), (a2) and (a3) will be described. In FIG. 413(a1), the pre-charge voltage V0 is applied for 1 μsec (the period of t1 to t0) at the beginning of 1H. As shown in FIG. 413(a2), the overcurrent (pre-charge current or discharge current) Id0 is applied to the source signal line 18 for the period of (t1) to t5 at the beginning of 1H.

As shown in FIG. 413(a3), the potential of the source signal line 18 is the voltage potential V0 of 0 gradation in the period of t1 to t0. In the period of t0 to t5, the potential of the source signal line 18 drastically drops due to Id0 (it is in the absorption current direction by way of example, and the above is the same as the other embodiments of the present invention). The current program on the video data is implemented in the period from t5 to t2 (the end of 1H). Therefore, the potential of the source signal line 18 lowers so as to pass the current matching with the program current through the driving transistor 11a of the pixel 16.

As described above, it is possible, by using the overcurrent (pre-charge current or discharge current) Id of a proper size for control from the target program current or the potential of the source signal line 18, to adjust the application time or the size of the overcurrents (pre-charge currents or discharge currents) so as to implement the accurate current program. It is also possible to theoretically estimate or speculate the potential change of the source signal line 18 so that it is easy to control or set it with the controller circuit (IC) 760 (not shown in drawings). For that reason, it is possible to implement a good and accurate current program.

Similarly, FIGS. 413(b1), (b2) and (b3) will be described. In FIG. 413(b1), the pre-charge voltage V0 is applied for 1 μsec from t0 (the period of t0 to t3). The overcurrent (pre-charge current or discharge current) Id0 is applied to the source signal line 18 in the period of (t1) to t5 in the beginning of 1H as shown in FIG. 413(b2).

As shown in FIG. 413(b3), in the period of t1 to t0, the potential of the source signal line 18 starts the change from the potential preceding by 1H (the potential of the source signal line 18 applied to implement the current program to the preceding pixel line). Thereafter, at t0, the pre-charge voltage V0 is applied for 1 μsec from t0 (the period of t0 to t1). Therefore, the potential of the source signal line 18 is reset to V0.

In the period of t3 to t5, the potential of the source signal line 18 drastically drops due to Id0 (it is in the absorption current direction by way of example, and the above is the same as the other embodiments of the present invention). The current program on the video data is implemented in the period from t5 to t2 (the end of 1H). Therefore, the potential of the source signal line 18 lowers so as to pass the current matching with the program current through the driving transistor 11a of the pixel 16.

As described above, it is possible, by applying the pre-charge current at arbitrary time, to use the overcurrent (pre-charge current or discharge current) Id of the proper size for control from the potential of the source signal line 18 (voltage V0 in FIGS. 413) prescribed in arbitrary timing and adjust the application time or size of the overcurrent (pre-charge current or discharge current) so as to implement the accurate current program. It is also possible to theoretically estimate or speculate the potential change of the source signal line 18 so that it is easy to control or set it with the controller circuit (IC) 760 (not shown in drawings). For that reason, it is possible to implement a good and accurate current program.

FIG. 413(c) is similar to FIG. 413(b). In FIG. 413(c1), the pre-charge voltage V0 is applied for 1 μsec from t3 (the period of t3 to t4). The overcurrent (pre-charge current or discharge current) Id0 is applied to the source signal line 18 in the period of (t1) to t5 in the beginning of 1H as shown in FIG. 413(b2).

As shown in FIG. 413(c3), in the period of t1 to t3, the potential of the source signal line 18 starts the change from the potential preceding by 1H (the potential of the source signal line 18 applied to implement the current program to the preceding pixel line). Thereafter, at t3, the pre-charge voltage V0 is applied for 1 μsec from t3 (the period of t3 to t4). Therefore, the potential of the source signal line 18 is reset to V0.

In the period of t4 to t5, the potential of the source signal line 18 drastically drops due to Id0 (it is in the absorption current direction by way of example, and the above is the same as the other embodiments of the present invention). The current program on the video data is implemented in the period from t5 to t2 (the end of 1H). Therefore, the potential of the source signal line 18 lowers so as to pass the current matching with the program current through the driving transistor 11a of the pixel 16.

As described above, it is possible, by applying the pre-charge voltage at arbitrary time, to change the potential of the source signal line 18 to a constant value. The size of the overcurrent (pre-charge current or discharge current) Id is the same. Therefore, the change curve of the overcurrent (pre-charge current or discharge current) Id has a constant angle of gradient. It is possible to use the overcurrent (pre-charge current or discharge current) Id of a prescribed proper size for control from the potential of the source signal line 18 (voltage V0 in FIGS. 413) prescribed in arbitrary timing and adjust the application time or size of the overcurrent (pre-charge current or discharge current) so as to change the potential of the source signal line 18 to be close to the target potential. After the potential becomes close, it only has to be corrected by the program current so that the accurate current program can be implemented. It is also possible to theoretically estimate or speculate the potential change of the source signal line 18 so that it is easy to control or set it with the controller circuit (IC) 760 (not shown in drawings).

In FIGS. 410 to 413, the direction of the overcurrent (pre-charge current) is described by exemplifying the current (sink current) in the direction for absorbing it into the source driver circuit (IC) 14. However, the present invention is not limited thereto. The overcurrent (pre-charge current) may also be in the discharge direction. The overcurrent (pre-charge current or discharge current) may also have both the discharge current and absorption current.

FIG. 415 is a schematic diagram of the driving method in the case of using both the discharge current and absorption current for the overcurrent (pre-charge current or discharge current). The circuit configuration is exemplified by the configuration of FIG. 414. In FIG. 415, the switch 151a is used for the on and off control of the pre-charge voltage. When it is on, the pre-charge voltage is applied to the terminal 155. The switch Dc2 is used for the on and off control of the pre-charge current in the discharge direction. When it is on, the pre-charge current in the discharge direction is applied to the terminal 155. The switch Dc1 is used for the on and off control of the pre-charge current in the absorbing direction. When it is on, the pre-charge current in the absorbing direction is applied to the terminal 155.

In the period of a in FIG. 415, the pre-charge voltage V0 is applied for 1 μsec at the beginning of 1H. The switch Dc1 of FIG. 415 is on for the period of t1 to ta. Therefore, the overcurrent Id1 in the absorbing direction flows. The potential of the source signal line 18 is the voltage potential V0 of 0 gradation for the period of 1 μsec from t1. Thereafter, the potential of the source signal line 18 drops drastically due to the overcurrent (pre-charge current) Id0 for the period up to ta. In the period of ta to t2, the current program on the video data is implemented. Therefore, the potential of the source signal line 18 drops so as to pass the current matching with the program current through the driving transistor 11a of the pixel 16.

In the period of b in FIG. 415, the pre-charge voltage is not applied. The switch Dc2 of FIG. 415 is on for the period of t2 to tb. Therefore, the overcurrent Id2 in the discharge direction flows. The potential of the source signal line 18 drastically rises due to the overcurrent (pre-charge current) Id2. In the period of tb to t3, the current program on the video data is implemented. Therefore, the potential of the source signal line 18 drops so as to pass the current matching with the program current through the driving transistor 11a of the pixel 16.

In the period of c in FIG. 415, the pre-charge voltage V0 is applied for 1 μsec at the beginning of 1H for the sake of writing to the low gradation region. The switches Dc1 and Dc2 of FIG. 415 are in the off state. The potential of the source signal line 18 is the voltage potential V0 of 0 gradation for the period of 1 μsec from t3. In the period of up to t4, the current program on the video data is implemented. Therefore, the potential of the source signal line 18 drops so as to pass the current matching with the program current through the driving transistor 11a of the pixel 16.

In the period of d in FIG. 415, the pre-charge voltage V0 is applied for 1 μsec at the beginning of 1H. The switch Dc1 of FIG. 415 is on for the period of t4 to td. Therefore, the overcurrent Id1 in the absorbing direction flows. The potential of the source signal line 18 is the voltage potential V0 of 0 gradation for the period of 1 μsec from t4.

Thereafter, the potential of the source signal line 18 drops drastically due to the overcurrent (pre-charge current) Id0 for the period up to td. In the period of td to t5, the current program on the video data is implemented. Therefore, the potential of the source signal line 18 drops so as to pass the current matching with the program current through the driving transistor 11a of the pixel 16.

In the period of e in FIG. 415, the pre-charge voltage is not applied. The switch Dc2 of FIG. 415 is on for the period of t5 to te. Therefore, the overcurrent Id2 in the discharge direction flows. The potential of the source signal line 18 drastically rises due to the overcurrent (pre-charge current) Id2. In the period of te to t6, the current program on the video data is implemented. Therefore, the potential of the source signal line 18 drops so as to pass the current matching with the program current through the driving transistor 11a of the pixel 16.

As described above, it is possible, by using the overcurrent (pre-charge current or discharge current) Id of a proper size for control from the target program current or the potential of the source signal line 18, to adjust the application time or the size of the overcurrents (pre-charge currents or discharge currents) so as to implement the accurate current program. It is also possible to theoretically estimate or speculate the potential change of the source signal line 18 so that it is easy to control or set it with the controller circuit (IC) 760 (not shown in drawings). For that reason, it is possible to implement a good and accurate current program.

The above embodiment is the embodiment of the overcurrent (pre-charge current or discharge current) driving and/or the pre-charge voltage driving in the 1H period. However, it is desirable to perform the overcurrent (pre-charge current or discharge current) driving and/or the pre-charge voltage driving in consideration of the potential state of the source signal line 18 not only in the 1H period but also in one frame or multiple horizontal scanning periods. FIG. 416 shows the embodiment.

To facilitate the description in FIG. 416 and so on, the number of gradations is 64. P means the pre-charge voltage driving, where P=1 means to apply the pre-charge voltage to the source signal line 18 and P=0 means to apply no pre-charge voltage to the source signal line 18. K means the overcurrent (pre-charge current) driving, where K=1 means to apply the pre-charge current to the source signal line 18 and K=0 means to apply no pre-charge current to the source signal line 18.

In FIG. 416, one section of the table indicates the 1H period or a select period of one pixel line. The number described on top of the table indicates a pixel line number. The number in the video data field indicates the size (0 to 63) of the video data. In FIG. 416, only the changes of the symbols P and K are described. As for actual control timing and size of applied current or applied voltage, the embodiments described in FIGS. 403 to 415 are applicable.

In FIG. 416, the video data changes from 36 to 0 on the third pixel line to the fourth pixel line. Therefore, to completely implement black writing, there is P=1 on the fourth pixel line to apply the pre-charge voltage (V0) to the source signal line 18.

The video data changes from 0 to 1 on the fifth pixel line to the sixth pixel line. There is a large potential difference between the voltage V0 and the voltage V1 as shown in FIG. 356. Therefore, to completely implement the current writing of gradation 1, there is K=1 on the sixth pixel line to apply the pre-charge current (I1) to the source signal line 18. Suffixes indicated to I1 and so on indicate the target gradations.

The video data changes from 1 to 8 on the sixth pixel line to the seventh pixel line. 8−1=7 difference in gradation is the relatively low gradation region. Therefore, to completely implement the current writing of gradation 8, there is K=1 on the seventh pixel line to apply the pre-charge current (I8) to the source signal line 18.

The video data changes from 8 to 0 on the eighth pixel line to the ninth pixel line. Therefore, to completely implement black writing, there is P=1 on the ninth pixel line to apply the pre-charge voltage (V0) to the source signal line 18.

Furthermore, the video data changes from 0 to 4 on the ninth pixel line to the tenth pixel line. 4−0=4 difference in gradation is the relatively low gradation region. The voltage V0 is close to the anode voltage Vdd and has a high potential. Therefore, to completely implement the current writing of gradation 4, there is K=1 on the tenth pixel line to apply the pre-charge current (I4) to the source signal line 18.

The video data changes from 60 to 1 on the eleventh to the twelfth pixel line. Therefore, the potential difference is large. Further, the voltage V1 is close to the anode voltage Vdd and has a high potential. For that reason, to completely implement the current writing of gradation 1, there is P=1 on the twelfth pixel line to write the pre-charge voltage (V0) first and reset the potential of the source signal line 18, and there is further K=1 to apply the pre-charge current (I1) to the source signal line 18.

Furthermore, the video data changes from 1 to 2 on the twelfth to the thirteenth pixel line. The difference in gradation is small. However, it is the low gradation region. And the voltage V1 is close to the anode voltage Vdd and has a high potential. There is a large potential difference between the voltage V2 and the voltage V1 as shown in FIG. 356. Therefore, to completely implement the current writing of gradation 2, there is K=1 on the thirteenth pixel line to apply the pre-charge current (I2) to the source signal line 18.

Furthermore, the video data changes from 2 to 0 on the thirteenth to the fourteenth pixel line. Gradation 0 is a state in which the program current is 0. Therefore, it is not possible to change the potential of the source signal line 18. Therefore, to completely implement black writing, there is P=1 on the fourteenth pixel line to apply the pre-charge voltage (V0) to the source signal line 18.

FIG. 417 is another embodiment of the present invention. In FIG. 417, the video data changes from 38 to 0 on the first to the second pixel line. Therefore, to completely implement black writing, there is P=1 on the second pixel line to apply the pre-charge voltage (V0) to the source signal line 18. Gradation 0 continues from the second pixel line to the sixth pixel line. Therefore, the voltage V0 is maintained as the potential of the source signal line 18, and so it is not necessary to apply the pre-charge voltage from the second pixel line to the sixth pixel line.

Inversely, if the pre-charge voltage is applied, it is put in the display state of the voltage driving. It is not desirable because characteristic variations of the driving transistor 11a due to a laser shot are displayed and the image quality is lowered. As described above, the present invention is characterized by applying no pre-charge voltage in the low gradation region such as 0 gradation when there is no change in the gradation. The low gradation region is the region of ⅛ or less of the entire gradations. In the case of 64 gradations for instance, the 0^{th} to 7^{th} gradations are relevant. It is also is characterized by applying the pre-charge voltage of the voltage V0 when changing from a certain gradation to 0 gradation (when a gradation difference occurs).

The video data changes from 0 to 1 on the sixth pixel line to the seventh pixel line. There is a large potential difference between the voltage V0 and the voltage V1 as shown in FIG. 356. Therefore, to completely implement the current writing of gradation 1, there is K=1 on the sixth pixel line to apply the pre-charge current (I1) to the source signal line 18. Suffixes indicated to I1 and so on indicate the target gradations.

As described above, the present invention is characterized by applying the pre-charge current or the pre-charge voltage when the change in the gradation from 0 gradation to the low gradation region occurs. In particular, it is essential when changing from 0 gradation to 1 gradation.

FIG. 417 shows the embodiment of the present invention for applying the pre-charge voltage and the pre-charge current independently. The present invention is not limited to this. FIG. 418 is a schematic diagram of the driving method of the present invention of simultaneously applying the pre-charge voltage and the pre-charge current.

In FIG. 418, the video data changes from 38 to 1 on the first to the second pixel line. Therefore, to completely implement black writing, there is P=1 on the second pixel line to apply the pre-charge voltage (V0) to the source signal line 18. At the same time, there is K=1 to apply the pre-charge current (I1) to the source signal line 18. On the second pixel line, the potential of the source signal line 18 rises to the voltage V0 once due to the application of the pre-charge voltage. Thereafter, the potential of the source signal line 18 drops rapidly due to the overcurrent (pre-charge current). After the overcurrent stops, the program current corresponding to a normal video signal is applied to the source signal line 18.

Similarly, the video data changes from 0 to 1 on the sixth to the seventh pixel line. Therefore, to completely implement black writing, there is P=1 on the seventh pixel line to apply the pre-charge voltage (V0) to the source signal line 18. At the same time, there is K=1 to apply the pre-charge current (I1) to the source signal line 18. On the second pixel line, the potential of the source signal line 18 rises to the voltage V0 once due to the application of the pre-charge voltage. Thereafter, the potential of the source signal line 18 drops rapidly due to the overcurrent (pre-charge current). After the overcurrent stops, the program current corresponding to a normal video signal is applied to the source signal line 18.

The pre-charge voltage applied to the second pixel line and the seventh pixel line is not limited to V0. It may also be the voltage V1. In this case, the potential of the source signal line 18 changes due to the application of the pre-charge voltage V1. After the overcurrent stops, the program current corresponding to the normal video signal is applied to the source signal line 18.

The video data changes from 1 to 0 on the second to the third pixel line. Therefore, to completely implement black writing, there is P=1 on the seventh pixel line to apply the pre-charge voltage (V0) to the source signal line 18. Gradation 0 continues from the third pixel line to the sixth pixel line. Therefore, the voltage V0 is maintained as the potential of the source signal line 18, and so it is not necessary to apply the pre-charge voltage from the second pixel line to the sixth pixel line. Inversely, if the pre-charge voltage is applied, it is put in the display state of the voltage driving. It is not desirable because characteristic variations of the driving transistor 11a due to a laser shot are displayed and the image quality is lowered.

As described above, the present invention is characterized by applying no pre-charge voltage in the low gradation region such as 0 gradation when there is no change in the gradation. The low gradation region is the region of ⅛ or less of the entire gradations. In the case of 64 gradations for instance, the 0^{th} to 7^{th} gradations are relevant. It is also is characterized by applying the pre-charge voltage of the voltage V0 when changing from a certain gradation to 0 gradation (when a gradation difference occurs).

The video data changes from 1 to 2 on the tenth pixel line to the eleventh pixel line. There is a large potential difference between the voltage V1 and the voltage V2 as shown in FIG. 356. Therefore, to completely implement the current writing of gradation 2, there is K=1 on the sixth pixel line to apply the pre-charge current (I2) to the source signal line 18.

As described above, the present invention is characterized by applying the pre-charge current or the pre-charge voltage when the change in the gradation from 0 gradation to the low gradation region occurs. In particular, it is essential when changing from 0 gradation to 1 gradation. The present invention is also characterized by applying the pre-charge current or the pre-charge voltage even in the case where the difference in the gradation from the low gradation region such as 0 gradation is as small as 1 or 2. In particular, it is essential when changing from 0 gradation to 1 gradation.

FIG. 419 is also an explanatory diagram of a driver method in other embodiments according to the present invention. In FIG. 419, the pre-charge voltage is applied when changing to 0 gradation, and the pre-charge current is applied when changing from 0 gradation to 1 gradation or the low gradation.

In FIG. 419, the video data changes from 38 to 1 on the first pixel line to the second pixel line. Therefore, to completely implement black writing, there is P=1 on the second pixel line to apply the pre-charge voltage (V0) to the source signal line 18.

Furthermore, the video data changes from 0 to 1 on the second pixel line to the third pixel line. There is K=1 on the third pixel line to apply the pre-charge current (I1) to the source signal line 18.

Similarly, the video data changes from 12 to 0 on the 2 hundred and thirty seventh pixel line to the two hundred and thirty eighth pixel line. Therefore, to completely implement black writing, there is P=1 on the two hundred and thirty eighth pixel line to apply the pre-charge voltage (V0) to the source signal line 18.

FIG. 420 is also an explanatory diagram of a driver method in other embodiments according to the present invention. In FIG. 420, multiple pre-charge voltages corresponding to the low gradations of the low gradation region are applied. It is possible, as described above, to apply the voltages correspondingly to the gradations and thereby implement a good gradation display.

In FIG. 420, the video data changes from 34 to 1 on the third pixel line to the fourth pixel line. Therefore, to completely implement black writing, there is P=1 on the second pixel line to apply the pre-charge voltage (V0) to the source signal line 18.

The video data changes from 0 to 1 on the fourth pixel line to the fifth pixel line. Therefore, to implement black writing for one gradation, there is P=1 on the second pixel line to apply the pre-charge voltage (V1) to the source signal line 18.

The video data changes from 1 to 2 on the fifth pixel line to the sixth pixel line. Therefore, to implement black writing for two gradations, there is P=1 on the second pixel line to apply the pre-charge voltage (V1) to the source signal line 18. At the same time, there is K=1 to apply the pre-charge current (I2) to the source signal line 18. On the sixth pixel line, the potential of the source signal line 18 drops to the voltage V1 once due to the application of the pre-charge voltage. Thereafter, the potential of the source signal line 18 further drops due to the overcurrent (pre-charge current) I2. After the overcurrent stops, the program current corresponding to the normal video signal is applied to the source signal line 18 so as to implement the target gradation display.

FIG. 421 is also an explanatory diagram of a driver method in other embodiments according to the present invention. FIG. 421 shows the control method of the driving circuit of the configuration shown in FIG. 414. It controls the pre-charge current in the absorbing direction corresponding to the low gradations of the low gradation region (reference character KL denotes a control symbol, and IL denotes the current) and the pre-charge current in the discharge direction corresponding to the high gradations (reference character KH denotes the control symbol, and IH denotes the current).

In FIG. 421, the video data changes from 38 to 0 on the first pixel line to the second pixel line. Therefore, to completely implement black writing, there is P=1 on the second pixel line to apply the pre-charge voltage (V0) to the source signal line 18.

The video data changes from 0 to 2 on the sixth pixel line to the seventh pixel line. Therefore, there is K=1 to apply the pre-charge current (IL2) to the source signal line 18. The potential of the source signal line 18 further drops due to the overcurrent (pre-charge current) IL2. After the overcurrent stops, the program current corresponding to the normal video signal is applied to the source signal line 18 so as to implement the target gradation display.

The video data changes from 2 to 63 on the ninth pixel line to the tenth pixel line. Therefore, there is K=1 to apply the pre-charge current (IH63) to the source signal line 18. The potential of the source signal line 18 further rises due to the overcurrent (pre-charge current) IH63. After the overcurrent stops, the program current corresponding to the normal video signal is applied to the source signal line 18 so as to implement the target gradation display.

In the case where the same gradation continues, the present invention determines the difference in the gradation between the gradation preceding by 1H and the next gradation so as to determine the P and K symbols. It controls the size of the pre-charge voltage and pre-charge current, the application timing and application time. To implement such control, there is a need for a line memory for holding the video data of the pixel lines in the controller circuit (IC) 760. If the video data is 8 bits, however, there is a need for the memory of 8 bits×horizontal direction pixel number×3 (RGB). As the line memory is directly connected to an increase in the cost, the number of bits of the line memory should be as small as possible.

FIG. 422 is a schematic diagram of the method of reducing the line memory. FIG. 422 can hold two set values (setting 1 and setting 2). The set values are settable by a microcomputer from outside the controller circuit (IC) 760. The set values are used to determine the size of the video data. If the video data is larger than the setting 1, 1 is set at a b0 bit.

If the set values are small, the b0 bit is 0. If the video data is larger than the setting 2, 1 is set at a b1 bit. As a matter of course, the set value may be one and the holding bit b may also be one if the determination is 1.

For instance, the video data is “00010100.” The setting 1 is “00010000.” The setting 2 is “00000100.” As the video data is “00001100” and the setting 1 is “00010000,” the video data is smaller than the setting 1. Therefore, the b0 bit is 0. Furthermore, as the video data is “00001100” and the setting 2 is “00000100,” the video data is larger than the setting 2. Therefore, the b1 bit is 1.

Consequently, it is possible to indicate that the video data is smaller than the setting 1 and larger than the setting 2 by 2 bits of b0 and b1. These two bits are held in memory. As described above, the size of each of the video data can be indicated by 2 bits.

The b0 and b1 signals are generated in the controller circuit (IC) 760 and transmitted to the source driver circuit (IC) 14. The transmitted b0 and b1 signals are decoded in the source driver circuit (IC) 14 as shown in FIG. 431. As a matter of course, table conversion is also feasible. FIG. 431 shows the case of three pre-charge voltages as in FIG. 427.

According to the embodiment of FIG. 431, when (b0, b1)=(0, 0), it is all open, that is, the pre-charge voltage (current) driving is not implemented. When (b0, b1)=(0, 1), the pre-charge voltage V0 is outputted. Likewise, when (b0, b1)=(1, 0), the pre-charge voltage V1 is outputted. And when (b0, b1)=(1, 1), the pre-charge voltage V2 is outputted.

What is important in the driving method of the present invention is whether 0 gradation or the low gradation region and how large the difference in the gradation between the gradation preceding by 1H and the next gradation is. These determinations can be obtained by the determination bits b (b0, b1) of the settings 1 and 2. Therefore, it is sufficient to hold the determination bit b of the size of each of the video data while there is no need for the line memory of the video data. For that reason, the cost can be reduced.

In FIGS. 381 to 422, description are given as to the embodiments for charging and discharging the parasitic capacitance Cs of the source signal line 18 by the overcurrent driving (pre-charge current driving) The problem of the overcurrent (pre-charge current or discharge current) driving is that the potential of the source signal line 18 cannot be stopped at the target potential. In the period when the switch Dc is on (closed), the overcurrent (pre-charge current or discharge current) Id passes through the source signal line 18.

This problem can be solved by adding a comparator for monitoring the potential of the source signal line 18. To be more specific, the potential change of the source signal line 18 should be monitored by the comparator. And if the potential of the source signal line 18 reaches the target gradation potential, an off signal should be generated from the comparator to turn off (open) the switch Dc. The above circuit can be easily configured with the operational amplifier. The operational amplifier can be easily formed or configured by the low-temperature polysilicon technique, CGS technique and high-temperature polysilicon technique. It is also easy to form the comparator in the source driver circuit (IC) 14.

In the case where 0 gradation continues after implementing the voltage pre-charge of 0 gradation (V0), the voltage pre-charge (0 gradation voltage) for the relevant pixel (for the source signal line 18) is not necessary. In the case where it changes to 1 gradation or more after implementing the voltage pre-charge of 0 gradation, however, it is desirable to implement the voltage pre-charge relevant to 1 gradation or more (voltage of V1 or more). It is because the potential difference between the voltage V0 and the voltage V1 is large as described in FIG. 356. It is because, if the potential difference is large, the program current of gradation 1 or so cannot reach the target potential of the source signal line 18 in the 1H period (it remains at a much farther potential).

The current driving method of the present invention implements the voltage pre-charge at 0 gradation display. When changing to 1 gradation or more, it implements the voltage pre-charge of 1 gradation or more. It is possible, by implementing the voltage pre-charge of 1 gradation or more, to program it so as to pass the target program current through the driving transistor 11a of the pixel 16.

It is desirable to implement the voltage pre-charge of 2 gradations or more when implementing the voltage pre-charge at 1 gradation display (when at the potential of the source signal line 18 of 1 gradation display even if not implemented) and changing to 2 gradations or more. It is possible, by implementing the voltage pre-charge of 2 gradations or more, to program it so as to pass the target program current through the driving transistor 11a of the pixel 16. The potential difference is relatively large even in the case of 1 or 2 gradation display. It is because there are the cases where the program current of gradation 2 or so cannot reach the target potential of the source signal line 18 in the 1H period.

The current driving method of the present invention implements the voltage pre-charge at 0 gradation display. When changing to 1 gradation or more, it implements the voltage pre-charge of 1 gradation or more. However, the present invention is not limited to this. It goes without saying that the voltage pre-charge of 1 gradation or more may be replaced by the overcurrent (pre-charge current or discharge current) driving described in FIGS. 381 to 422. It is also possible to implement both the voltage pre-charge and the overcurrent (pre-charge current or discharge current) driving.

It is desirable, as described, to implement the voltage pre-charge of 2 gradations or more when implementing the voltage pre-charge at 1 gradation display and changing to 2 gradations or more. In this case, it goes without saying that it is possible, by implementing the overcurrent driving (current pre-charge driving) of 2 gradations or more, to program it so as to pass the target program current through the driving transistor 11a of the pixel 16.

In the case where the maximum value of the pre-charge voltage is gradation k and the voltage thereof is Vk, it is also possible, when changing from below gradation k to gradation k or more, to apply the pre-charge voltage Vk and then apply the pre-charge current and apply the program current. It is also possible to apply the pre-charge voltage Vk and then apply the program current. To be more specific, the potential is increased by applying the pre-charge voltage Vk. This operation can reduce the period for reaching the target potential.

The above embodiment has the configuration for applying the overcurrent (pre-charge current or discharge current) or the pre-charge voltage from the source driver circuit (IC) 14 to the source signal line 18. The present invention is not limited to this FIG. 445 has the configuration having means of supplying the overcurrent (pre-charge current or discharge current) formed or placed on the array.

In FIG. 445, a pixel 16p is the means of supplying the overcurrent. Although it is represented as the pixel 16p, what is important is an overcurrent driving transistor 11ap as shown in FIG. 446. It does not have to be a pixel 16 configuration.

In FIG. 445, pixels 16ap are formed or placed at the end of the source signal line 18 opposite to the side having the source driver circuit (IC) 14 placed thereon. However, the present invention is not limited to this. They may also be formed or placed on the source driver circuit (IC) 14 side or on both sides of the source signal line 18. For instance, FIG. 453 has the configuration in which overcurrent pixels 16p1 are placed on the source driver circuit (IC) 14 side and second overcurrent pixels 16p2 are placed at the ends of the source signal line 18. As shown in FIG. 453, it is possible, by placing the overcurrent pixels 16p at both ends of the source signal line 18, to have the potential of the source signal line 18 change averagely at both ends of the source signal line 18 on the pre-charge driving so as to implement an even image display without generating a luminance gradient on the screen 144.

The overcurrent driving transistor 11ap may be configured as a silicon chip and mounted on the array 30. As for the overcurrent driving transistor 11ap, it is preferable to have pixels 16a or the gate driver circuit 12 formed simultaneously by the polysilicon technique.

The overcurrent driving transistor 11ap has the output current different from that of the driving transistor 11a of the pixel 16a. When a voltage Vg1 applied to the gate terminal of the driving transistor 11a of the pixel 16a (pixel for image display) is the same as a voltage Vg2 applied to the gate terminal of the pixel overcurrent driving transistor 11ap of the pixel 16p (pixel for supplying or outputting the overcurrent) (Vg1=Vg2), a relation of I2=bI1 (provided that b is 1 or more) should be satisfied by the current I1 outputted by the driving transistor 11a and the current I2 outputted by the overcurrent driving transistor 11ap. The relation of I2=bI1 (provided that b is 1 or more) can be set up easily by designing the WL size or WL ratio of the overcurrent driving transistor hap and the driving transistor 11a.

It is desirable to render the form of the overcurrent driving transistor hap of the pixel 16p the same as that of the driving transistor 11a and form or place multiple driving transistors 11a in parallel so as to configure the relation of I2=bI1.

For instance, a channel width of the driving transistor 11a is 20 μm and a channel length L thereof is 12 μm, and the output current on applying the voltage Vg1 to a gate terminal G of the driving transistor 11a is I1. And the channel width of one overcurrent driving transistor 11ap is 20 μm and a channel length L thereof is 12 μm, and the output current added on applying the voltage Vg1 to the gate terminals G of six overcurrent driving transistors hap coupled in parallel to configure the overcurrent pixel 16p is I2. In this case, it is possible to configure a relation of I2=6I1 (b=6). It is possible to render the form of the overcurrent driving transistor 11ap the same as that of the driving transistor 11a so as to accurately set or design the value of b. Therefore, it is not limited to the configuration of FIG. 446 in which there is one overcurrent driving transistor hap to the pixel 16p.

It goes without saying that, as another configuration, multiple overcurrent driving transistors 11ap may be coupled in series or in parallel as shown in FIG. 450. These overcurrent driving transistors 11ap are connected to the source signal line 18 via a transistor 11cp as selection means. As described above, it is possible to reduce the variations in the overcurrent (pre-charge current or discharge current) by forming or configuring the multiple transistors hap for supplying the overcurrent (pre-charge current or discharge current).

In the case of forming the transistors 11ap by the (low-temperature) polysilicon technique, it is desirable to form them dispersedly on the array 30 because there are significant variations in their characteristics. Therefore, in the case of forming the overcurrent driving transistors 11ap as in FIG. 450, it is desirable to place them as extensively as possible. It is further desirable to form multiple overcurrent pixels 16p (16pa, 16pb, 16pc and 16pd) and couple them in a wide range as shown in FIG. 451.

In FIG. 451, the overcurrent pixels 16p which are shaded are not coupled to any source signal line 18 (not used). However, without the overcurrent pixels 16p which are shaded, the overcurrent pixels 16p (16pa, 16pb, 16pc and 16pd) formed adjacently to the shaded overcurrent pixels 16p have different characteristics from the other overcurrent pixels 16p. This is because, unless a pattern is regularly formed, the parts surrounding the formed transistors are put in different states of etching and the characteristics change. It is possible, as shown in FIG. 451, to form the shaded overcurrent pixels 16p and thereby eliminate the variations in the characteristics and equalize them. Needless to say, the above can be applied to other embodiments in the present invention.

To reduce the influence of the variations in the characteristics of the overcurrent pixels 16p, the method of switching the overcurrent pixels 16p selected in a switching circuit S is exemplified as shown in FIG. 452. The switching circuit S has the pixel 16a or the gate driver circuit 12 formed simultaneously by the polysilicon technique. The switching circuit S can be formed or configured easily by the low-temperature polysilicon technique, CGS technique and high-temperature polysilicon technique. It is also easy to form it in the source driver circuit (IC) 14. Needless to say, the above can be applied to other embodiments in the present invention.

The switching circuit alternately switches the overcurrent pixels (16p1, 16p2) selected for each 1H. It may also be switched for each 1F (1 frame or 1 field). It is also possible to exert control by switching them randomly so as to match the number of times of selecting the overcurrent pixels 16p1 with the number of times of selecting the overcurrent pixels 16p2 on average. It is also possible to change the overcurrent pixels 16p to be selected between an odd-numbered field and an even-numbered field.

The overcurrent driving transistors 11ap of the overcurrent pixels 16p of FIG. 446 are shown as the P-channel transistors. However, the present invention is not limited to this. The overcurrent driving transistors 11ap may also be configured or formed by the N-channel transistors. In the case where the driving transistors 11ap of the pixels 16a are P-channel, it is desirable to form or configure the overcurrent driving transistors hap with the P-channels. In the case where the driving transistors 11a of the pixels 16a are N-channel, it is desirable to form or configure the overcurrent driving transistors hap with the N-channels.

As shown in FIG. 448, it is also possible to form or place both the overcurrent pixels 16p having the P-channel overcurrent driving transistors 11ap and overcurrent pixels 16n having the N-channel overcurrent driving transistors 11an. When discharging the overcurrent to the source signal line 18, the on voltage is applied to a gate signal line 17pp to put a switching transistor 11cpp in the on state. When absorbing the overcurrent from the source signal line 18, the on voltage is applied to a gate signal line 17pn to put a switching transistor 11cpn in the on state. It is also possible to select both the gate signal line 17pp and gate signal line 17pn and apply a difference between the overcurrent in the discharging direction and the overcurrent in the absorbing direction to the source signal line 18.

In FIG. 446, the source terminal of the overcurrent driving transistor 11ap of the overcurrent pixel 16p is connected to a voltage Vct. It is possible to reduce the number of power supplies by rendering the voltage Vct equal to the voltage Vdd (anode voltage).

To adjust or change the size of the current outputted by the overcurrent driving transistors 11ap, it is desirable to be able to change the voltage Vct in FIG. 446. FIG. 449 shows that embodiment. In FIG. 449, a regulator VR is placed between a voltage Vtt higher than the voltage Vct and GND. It is possible to adjust the voltage Vct with the regulator VR. It is possible to render the size of the overcurrent larger by increasing the voltage Vct.

FIG. 447 has the configuration in which the voltage Vct is changeable by VPDATA applied to the electronic regulator 501. It is possible to adjust, change or vary the size of the overcurrent by using VPDATA. It is also possible, even while applying the overcurrent, to adjust, change or vary the size of the overcurrent by changing VPDATA. It is also possible, by changing VPDATA, to vary or change the size of the overcurrent by pixel line or by multiple pixel lines or by frame or by multiple frames.

In FIG. 448, it is possible to implement the size of the overcurrent of the P-channel overcurrent driving transistor 11ap by changing a voltage Vctp. It is possible to implement the size of the overcurrent of the N-channel overcurrent driving transistor 11an by changing a voltage Vctn.

The overcurrent pixel 16p of FIG. 446 has no capacitor for holding the gate terminal potential of the overcurrent driving transistor 11ap formed thereon. However, the present invention is not limited thereto. It is also possible, as shown in FIG. 447, to form or place a capacitor 19p on the overcurrent pixel 16p. Placement of the capacitor 19p improves retention property.

FIG. 445 has the configuration in which one overcurrent pixel 16p is placed on each source signal line 18. The present invention is not limited thereto. FIG. 454 has the configuration in which multiple overcurrent pixels 16p are placed on one source signal line 18 to be able to vary or adjust the number of the overcurrent pixels 16p to be selected.

In FIG. 445, the number of the overcurrent pixels 16p to be selected is 0 to 3. The number of the overcurrent pixels 16p is selected by a gate driver circuit (IC) 12p. When the gate driver circuit (IC) 12p selects three overcurrent driving transistors 11ap, an on voltage is applied to gate signal lines 17p1, 17p2, and 17p3. The gate driver circuit (IC) 12p can be easily formed or configured by the low-temperature polysilicon technique, CGS technique and high-temperature polysilicon technique. It goes without saying that the above matters are also applicable to the other embodiments of the present invention.

The discharge current of an overcurrent driving transistor 11ap1 is applied to the source signal line 18 by applying the on voltage to a gate signal line 17p1. The discharge current of an overcurrent driving transistor 11ap2 is applied to the source signal line 18 by applying the on voltage to a gate signal line 17p2. Further, the discharge current of an overcurrent driving transistor 11ap3 is applied to the source signal line 18 by applying the on voltage to a gate signal line 17p3.

For instance, in the case where the output currents of the overcurrent driving transistors 11ap1 to 11ap3 are the same, it is possible, by selecting two gate signal lines 17p, to obtain an overcurrent output twice larger than that in the case of selecting one gate signal line 17p. It is also possible, by selecting three gate signal lines 17p, to obtain an overcurrent output three times larger than that in the case of selecting one gate signal line 17p.

In FIG. 454, the capacitor 19 is not placed on the pixel 16p. One capacitor 19 is placed for multiple pixels 16p or for one line of the pixels 16p.

In FIG. 454, it is described that a discharge current I21 of the overcurrent pixel 16p1, a discharge current I22 of the overcurrent pixel 16p2 and a discharge current I23 of the overcurrent pixel 16p3 are the same. However, it is not limited thereto. It goes without saying that it is possible to differentiate the size of the overcurrent driving transistors 11ap of the pixels 16p1 to 16p3 or the number of the overcurrent driving transistors 11ap formed. In this case, the discharge current I21 of the overcurrent pixel 16p1, the discharge current I22 of the overcurrent pixel 16p2 and the discharge current I23 of the overcurrent pixel 16p3 can be different. Therefore, it is possible to differentiate the size of the overcurrents even if the gate signal line 17p selected by the gate driver circuit 12p is one gate signal line.

In FIG. 446, one line of the pixels 16p is selected by applying the on voltage to the gate signal line 17p. However, the present invention is not limited thereto. As shown in FIG. 449 for instance, a selection driver circuit (IC) 4491 selects each overcurrent pixel 16p and turns on a switching transistor 11cp of the selected pixel 16p. Therefore, it is possible to select whether or not to apply the overcurrent to each source signal line 18.

It is controlled by the controller circuit (IC) 760 as to which source signal line 18 the overcurrent should be applied to. As a matter of course, it may also be implemented by the source driver circuit (IC) 14. The selection driver circuit (IC) 4491 can be easily formed or configured by the low-temperature polysilicon technique, CGS technique and high-temperature polysilicon technique. It may also be built into the source driver circuit (IC) 14. It goes without saying that the above matters are also applicable to the other embodiments of the present invention.

The on and off control of the gate signal line 17p is implemented by control of the controller circuit (IC) 760. The controller circuit (IC) 760 implements the duty ratio control, reference current ratio control and so on by processing the video signal. Overcurrent control is exerted correspondingly to this implementation. The overcurrent control is not specifically implemented by the control of the controller circuit (IC) 760 but may be implemented by another circuit. For instance, the source driver circuit (IC) 14 is exemplified.

The voltages applied to the gate signal line 17p are Vgh and Vgl. The output voltages from the controller circuit (IC) 760 are 0 (GND) and 3.3 (V). These voltages need to be level-shifted to Vgh and Vgl. The level-shift is implemented by the gate driver circuit 12a.

It goes without saying that the configurations described in FIGS. 445 to 454 may be configured or formed singly or in combination. For instance, the configuration of FIG. 445 and the configuration of FIG. 454 are mutually replaceable. The difference is whether to control one gate signal line 17p or to control three gate signal lines 17p1 to 17p3. Those skilled in the art can easily implement or change this operation and adopt it. Even in the case of the configuration having both the P-channel overcurrent driving transistors 11ap and N-channel overcurrent driving transistors 11an in FIG. 448, those skilled in the art can easily implement or change it and adopt it. Here, to facilitate the description, configurations of FIGS. 445 and 446 are illustrated for the description hereinafter.

To facilitate the description, the following description will be given as to the driving method whereby the application time of the overcurrent (pre-charge current) is ½(=1/(2H)) of 1 horizontal scanning period (1H) and the normal program current is applied in the remaining 1/(2H) period. However, the application time of the overcurrent is not limited to the 1/(2H) period. It goes without saying that it may be another period (time), such as 1/(4H) or 3/(4H).

In the period for applying the overcurrent in the configuration of FIG. 445, the on voltage (Vg1) for putting the switching transistors 11cp in the on state is applied to the gate signal line 17p. In this period, the on voltage is applied to the gate signal line 17p so that the overcurrent I2 is applied to the source signal line 18. In the period for applying the overcurrent, the gate signal line 17a corresponding to the pixel line to which the program current Iw as the video signal is written may stay in the state of having the off voltage applied thereto. As a matter of course, the on voltage may be applied to the gate signal line 17a corresponding to the pixel line to which the program current Iw as the video signal is written. It is because, in the case of the current program method, no failure occurs to the operation even if multiple current sources are connected to one source signal line 18. It is possible, depending on the condition, to reach the predetermined potential of the source signal line earlier by applying the program current Iw and overcurrent I2 simultaneously to the source signal line 18.

The source driver circuit (IC) 14 is operated in the application period of the overcurrent I2. In this case, the reference current ratio of the source driver circuit (IC) 14 is increased. The configuration and method of controlling the reference current ratio were previously described, and so a description thereof will be omitted. In FIG. 455, the reference current ratio is 2 (times) in the 1/(2H) period of t1 to ta. The reference current ratio is 1 (time) in the period for applying the normal program current Iw in the second half of 1H (2 periods of ta to t2).

In the first 1/(2H) period, the reference current ratio is changed according to the size of the video signal and the size of the video signal preceding by 1H. In the period (a), the video signal preceding by 1H changes from 0 (complete black display) to 1. Therefore, as for the change in the video signal, it is relatively small, such as 1−0=1. As described in FIG. 356, however, the potential difference between the voltage V0 corresponding to the video signal 0 and the voltage V1 corresponding to the video signal 1 is large. Considering this factor, the reference current ratio is 2 in the first 1/(2H) period of the period (a). Therefore, in the first 1/(2H) period, the current twice larger than the normal program current Iw is absorbed by the source driver circuit (IC) 14 from the source signal line 18. For that reason, the potential change of the source signal line 18 occurs by having the charge discharged at a speed twice faster than the case of applying the normal program current Iw. In the second 1/(2H) period of the period (a), the reference current ratio is 1 and the predetermined program current Iw is written to the pixel 16a. In this period, the off voltage is applied to the gate signal line 17p, and the switching transistors 11cp are putted in the off state. Therefore, the overcurrent (pre-charge current) is not applied to the source signal line 18.

According to the embodiment of the present invention, it is described that the overcurrent (pre-charge current) is applied from the pixel 16p. As for the operation for reducing the potential of the source signal line 18, however, the operation of the source driver circuit (IC) 14 is dominant as described in FIG. 380(a). Therefore, it is more appropriate to say that the overcurrent is applied from the source driver circuit (IC) 14 rather than the operation of the pixel 16p. As for the operation for increasing the potential of the source signal line 18, however, the operation of the pixel 16p is dominant as described in FIG. 380(b). The operation becomes an opposite operation through the driving transistors 11a and the overcurrent driving transistors 11ap (11an: refer to FIG. 448). Here, a description will be given on condition that the overcurrent is supplied from the pixel 16p by increasing the reference current ratio of the source driver circuit (IC) 14 to facilitate the description.

As for the actual operation, there are the operations in which no overcurrent is supplied from the overcurrent pixel 16p and the cases where no overcurrent (pre-charge current) is applied from the source driver circuit (IC) 14. However, it is cumbersome to describe the operations by dividing them into the cases. Accordingly, the overcurrent pixel 16p and the source driver circuit (IC) 14 are controlled (driven) to operate simultaneously to reach the predetermined potential of the source signal line 18 so as to pass the target program current through the driving transistor 11a of the pixel 16a (pixel 16).

As described above, the technical category of the present invention is that at least the overcurrent (pre-charge current) is absorbed from or discharged to the source signal line 18 in the predetermined period. The technical category of the present invention is also that at least the overcurrent is absorbed from or discharged to the source signal line 18 in the predetermined period. Therefore, the technical category (technical scope or claims) of the present invention is not limited to the operations of the pixel 16p and the source driver circuit (IC) 14.

It goes without saying that the above matters are also applicable to the circuit configuration, the driving method, and the display panel (display apparatus) shown in FIGS. 127-142, 228-231, 308-313, 324, 328-354, 380-435, 445-467, and the like.

In FIG. 455, the period (b) shows the change from a video signal 1 of the period (a) to a video signal 6. To be more specific, it is necessary, in the period (b), to change from the potential of the source signal line 18 corresponding to the video signal 1 to that corresponding to the video signal 6. Therefore, as for the change in the video signal, it is relatively large, such as 6−1=5. Therefore, the potential change of the source signal line 18 is relatively large. Considering this factor, the reference current ratio is 3 in the first 1/(2H) period of the period (b). The on voltage is applied to the gate signal line 17p in the first 1/(2H) period of the period (b). In the first 1/(2H) period, the current three times larger than the normal program current Iw is absorbed by the source driver circuit (IC) 14 from the source signal line 18. For that reason, the potential change of the source signal line 18 occurs by having the charge discharged at a speed three times faster than the case of applying the normal program current Iw. In the second 1/(2H) period, the current as large as the normal program current Iw is absorbed by the source driver circuit (IC) 14 from the source signal line 18. The gate potential of the driving transistor 11a of the pixel 16a changes correspondingly to the program current, and the program current Iw is programmed on the pixel.

In FIG. 455(c), the reference current ratio is fixed at 1. The video signal is 6 in the period (b). The video signal is 1 in the period (c). Therefore, as for the change in the video signal, it is small, such as 1−6=−5. Therefore, it is necessary to increase the potential of the source signal line on the anode voltage Vdd side. In this case, the operation of the driving transistor 11a of the pixel 16 described in FIG. 380(b) is main, and so the reference current ratio of the source driver circuit (IC) 14 may be 1. It is shorted between the drain and the gate terminal of the driving transistor 11a of the pixel 16, and the source signal line 18 is electrically charged to increase the potential.

In FIG. 455 (d), the potential of the source signal line 18 preceding by 1H is the potential (V1) corresponding to the video signal 1. It is the video signal 10 in (d). Therefore, as for the difference in the video signal, it is large, such as 10−1=9. To be more specific, it is also necessary to drop the potential of the source signal line 18 significantly. Considering this factor, the reference current ratio is 4 in the first 1/ (2H) period of the period (d). Therefore, in the first 1/ (2H) period, the current four times larger than the normal program current Iw is absorbed by the source driver circuit (IC) 14 from the source signal line 18. For that reason, the potential change of the source signal line 18 occurs by having the charge discharged at a speed four times faster than the case of applying the normal program current Iw. In the second 1/(2H) period of the period (d), the reference current ratio is 1 and the predetermined program current Iw is written to the pixel 16a. In this period, the off voltage is applied to the gate signal line 17p, and the switching transistors 11cp are putted in the off state. Therefore, the overcurrent (pre-charge current) is not applied to the source signal line 18.

As for the period (e) (t5 to t6) of FIG. 455, it is the video signal 10 in the period preceding by 1H (t4 to t5) and it is also the video signal 10 in the period (d) (t5 to t6) so that there is no change. Therefore, in FIG. 455(e), the reference current ratio is fixed at 1. The pixel 16 operates according to Vt variations (characteristic variations) of the driving transistor 11a. The source signal line 18 has the current supplied from the driving transistor 11a, and the potential of the source signal line 18 is set at the potential to be balanced with the program current Iw flowing into the source signal line 18.

As described above, the potential change of the source signal line 18 is rendered earlier by the operation of the overcurrent driving transistor 11ap of the overcurrent pixel 16p and the increase in the reference current ratio of the source driver circuit (IC) 14 so as to write the predetermined program current Iw to the pixel 16.

As mentioned above, it goes without saying that the above matters are also applicable to the circuit configuration, the driving method, and the display panel (display apparatus) shown in FIGS. 127-142, 228-231, 308-313, 324, 328-354, 380-435, 445-467, and the like. It goes without saying that the above matters may be combined with another driving method of the present invention, such as the duty ratio control. The above matters are also applicable to the other embodiments of the present invention described hereunder.

FIG. 457 is a deformation example of the embodiment of FIG. 455. It is different from FIG. 455 in that the pre-charge voltage is applied in the period (c) (t3 to t4). The pre-charge voltage may be either the voltage V0 (gradation 0) or the voltage V1 (gradation 1). It is important, when the video signal turns to a small value from a large value (turns to the video signal 1 from the video signal 6 in (c)), to apply the voltage with the pre-charge voltage and increase the potential of the source signal line 18 on the anode voltage (Vdd) side.

To be more specific, when the source driver circuit (IC) 14 operates in the absorption current (sink current) direction and turns to a direction in which the video signal is small (when turning to a direction for reducing the current passed through the EL element 15), the present invention increases the potential of the source signal line 18 by means of the pre-charge voltage (changes the gate terminal potential not to pass the current through the driving transistor 11a). It is further desirable to implement the embodiments described in FIGS. 445 to 458. To be more specific, the overcurrent pixel 16p is operated to apply the overcurrent to the source signal line 18. Moreover, when the source driver circuit (IC) 14 operates in the discharge current direction and turns to a direction in which the video signal is small (when turning to a direction for reducing the current passed through the EL element 15), the present invention decreases the potential of the source signal line 18 by means of the pre-charge voltage (changes the gate terminal potential not to pass the current through the driving transistor 11a).

Whether or not to apply the pre-charge voltage is decided according to the video data preceding by 1H and the next video data. For instance, it is decided according to the period (b) (video data preceding by 1H) and period (c) (next video data). This relation is shown as an example in FIG. 463. It is controlled as in the table of FIG. 389. In the table of FIG. 463, 1 indicates applying the pre-charge voltage in the next 1H period, and 0 indicates applying no pre-charge voltage in the next 1H period. For instance, when the video data of the next 1H is 0, the pre-charge voltage is applied in the case where the video data preceding by 1H is 1 or more. Further, when the video data of the next 1H is 1, the pre-charge voltage is applied in the case where the video data preceding by 1H is 4 or more. Similarly, when the video data of the next 1H is 2, the pre-charge voltage is applied in the case where the video data preceding by 1H is 5 or more. In other cases, the pre-charge voltage is not applied.

As described above, the present invention decides whether or not to apply the pre-charge voltage according to the change in the video data. Therefore, a good image display can be implemented.

In FIG. 457, the period (b) (t2 to t3) has the video signal 6. As the period (c) (t3 to t4) has the video signal 1, it is necessary to increase the potential of the source signal line 18 on the anode potential side. However, the source driver circuit (IC) 14 uses the absorption current method (except the case of FIG. 414 where the potential of the source signal line 18 can be increased well without using the method of FIG. 457). Therefore, the source driver circuit (IC) 14 cannot increase the potential of the source signal line 18.

To solve this problem, the voltage driving previously described is implemented. In FIG. 457, the pre-charge voltage is applied to the source signal line 18 in the period of t3 to tf so as to increase the potential of the source signal line 18. The reference current ratio at this time should be 1. The program current Iw relevant to the video signal 1 is applied to the source signal line 18 from the source driver circuit (IC) 14. The other configurations and operations are the same as or similar to those of FIG. 455, and so a description thereof will be omitted.

According to the embodiments of FIGS. 455 and 457, the current to be the overcurrent is absorbed by the source driver circuit (IC) 14 in the first 1/(2H) period. In the second 1/(2H) period, the reference current ratio is 1 and the predetermined program current Iw is written to the pixel 16a. To be more specific, the application period of the overcurrent is fixed as a 1/(2H) period. However, the present invention is not limited thereto. The application period of the overcurrent may be changed.

FIG. 458 is the embodiment in which the application period of the overcurrent is changed. FIG. 458(1) is the same as FIG. 455, which is the embodiment in which the application period of the overcurrent is fixed as a 1/(2H) period. However, the reference current ratio is fixed at 4. As described above, the reference current ratio may be fixed as to the application period of the overcurrent. It is possible, by rendering the reference current ratio fixed, to simplify the circuit configuration and realize reduction in the cost.

FIG. 458(2) is the embodiment in which the application period of the overcurrent is changed according to the video data or the change in the video data (the potential of the source signal line 18 or the potential change of the source signal line 18).

According to the method of FIG. 458(2), the on voltage (Vgl) for putting the switching transistors 11cp in the on state is applied to the gate signal line 17p in the period for applying the overcurrent. In this period, the on voltage is applied to the gate signal line 17p so that the overcurrent I2 is applied to the source signal line 18. In the period for applying the overcurrent, the gate signal line 17a corresponding to the pixel line to which the program current Iw as the video signal is written may stay in the state of having the off voltage applied thereto. As a matter of course, the on voltage may be applied to the gate signal line 17a corresponding to the pixel line to which the program current Iw as the video signal is written. Hereunder, the embodiment of FIG. 458(2) will be described.

The source driver circuit (IC) 14 is operated in the application period of the overcurrent I2. In this case, the reference current ratio of the source driver circuit (IC) 14 is rendered larger. The configuration and method of controlling the reference current ratio were previously described, and so a description thereof will be omitted. In FIG. 455, the reference current ratio is 4 (times). The reference current ratio is 1 (time) after elapse of the application period of the overcurrent, that is, in the period for applying the normal program current Iw.

In the period (a) of FIG. 458(2), the video signal preceding by 1H changes from 0 (complete black display) to 1. Therefore, as for the change in the video signal, it is relatively small, such as 1−0=1. As described in FIG. 356, however, the potential difference between the voltage V0 corresponding to the video signal 0 and the voltage V1 corresponding to the video signal 1 is large. Considering this factor, the current of the reference current ratio 4 is applied in the 1/(4H) period of the first half of the period (a). Therefore, in the 1/(4H) period of the first half, the current four times larger than the normal program current Iw is absorbed by the source driver circuit (IC) 14 from the source signal line 18. For that reason, the potential change of the source signal line 18 occurs by having the charge discharged at a speed four times faster than the case of applying the normal program current Iw.

In the 3/(4H) period of the second half of the period (a), the reference current ratio is 1 and the predetermined program current Iw is written to the pixel 16a. In this period, the off voltage is applied to the gate signal line 17p and the switching transistor 11cp is put in the off state. Therefore, no overcurrent (pre-charge current) is applied to the source signal line 18.

In FIG. 458, the period (b) shows the change from the video signal 1 to the video signal 6 in the period (a). To be more specific, in the period (b), it is necessary to change from the potential of the source signal line 18 corresponding to the video signal 1 to the potential of the source signal line 18 corresponding to the video signal 6. Therefore, as for the change in the video signal, it is relatively large, such as 6−1=5. Therefore, the potential change of the source signal line 18 is also relatively large.

Considering this factor, the current of the reference current ratio 4 is applied in the 1/(2H) period of the first half of the period (b). The on voltage is applied to the gate signal line 17p in the 1/(2H) period of the first half of the period (b). In the 1/(2H) period of the first half, the current four times larger than the normal program current Iw is absorbed by the source driver circuit (IC) 14 from the source signal line 18. For that reason, the potential change of the source signal line 18 occurs by having the charge discharged at a speed four times faster than the case of applying the normal program current Iw. In the 1/(2H) period of the second half, the current as large as the normal program current Iw is absorbed by the source driver circuit (IC) 14 from the source signal line 18. The gate potential of the driving transistor 11a of the pixel 16a changes correspondingly to this program current, and the program current Iw is programmed on the pixel.

In FIG. 458(c), the reference current ratio is fixed at 1. The video signal is 6 in the period (b). The video signal is 1 in the period (c). Therefore, as for the change in the video signal, it is small, such as 1−6=−5. Therefore, it is necessary to increase the potential of the source signal line on the anode voltage Vdd side. In this case, the operation of the driving transistor 11a of the pixel 16 described in FIG. 380(b) is main, and so the reference current ratio of the source driver circuit (IC) 14 may be 1. It is shorted between the drain and the gate terminal of the driving transistor 11a of the pixel 16, and the source signal line 18 is electrically charged to increase the potential. It goes without saying that the pre-charge voltage may be applied as in the period (c) (t3 to t4) of FIG. 457.

In FIG. 458(d), the potential of the source signal line 18 preceding by 1H is the potential (V1) corresponding to the video signal 1. The video signal is 10 in the period (d). Therefore, the difference in the video signal is large, such as 10−1=9. To be more specific, it is also necessary to drop the potential of the source signal line 18 significantly.

Considering this factor, the pre-charge current is applied in the 3/(4H) period of the first half of the period (d). Therefore, in the 3/(4H) period of the first half, the current four times larger than the normal program current Iw is absorbed by the source driver circuit (IC) 14 from the source signal line 18. For that reason, the potential change of the source signal line 18 occurs by being electrically discharged at a speed four times faster than the case of applying the normal program current Iw. In the 1/(4H) period of the second half of the period (d), the reference current ratio is 1 and the predetermined program current Iw is written to the pixel 16a. In this period, the off voltage is applied to the gate signal line 17p and the switching transistor 11cp is put in the off state. Therefore, no overcurrent (pre-charge current) is applied to the source signal line 18.

As for the period (e) (t5 to t6) of FIG. 458, it is the video signal 10 in the period preceding by 1H (t4 to t5) and it is also the video signal 10 in the period (d) (t5 to t6) so that there is no change. In FIG. 455 (e), the reference current ratio is fixed at 1. The pixel 16 operates according to Vt variations (characteristic variations) of the driving transistor 11a. The source signal line 18 has the current supplied from the driving transistor 11a, and the potential of the source signal line 18 is set at the potential to be balanced with the program current Iw flowing into the source signal line 18.

As described above, the potential change of the source signal line 18 is rendered earlier by the operation of the overcurrent driving transistor 11ap of the overcurrent pixel 16p and the increase in the reference current ratio of the source driver circuit (IC) 14 so as to write the predetermined program current Iw to the pixel 16.

It goes without saying that the above matters are also applicable to the circuit configuration, the driving method, and the display panel (display apparatus) shown in FIGS. 127-142, 228-231, 308-313, 324, 328-354, 380-435, 445-467, and the like. It goes without saying that the above matters may be combined with another driving method of the present invention, such as the duty ratio control. The above matters are also applicable to the other embodiments of the present invention described hereunder.

The above embodiment is the embodiment for changing the reference current ratio and applying the overcurrent to the source signal line 18. To be more specific, it is not the embodiment for changing the size of the video signal in the period for applying the overcurrent. However, the present invention is not limited thereto.

FIGS. 459 show the embodiment in which the size of the video signal is changed in the period for applying the overcurrent. To facilitate the description in FIGS. 459, the video data is 2-bit-shifted (quadruple) and the reference current ratio is 1 time in the application period of the overcurrent by way of example. It goes without saying, however, that the reference current ratio may be larger than 1 in the application period of the overcurrent.

In FIG. 459 (1), the video data of the period (a) is 1. If the video data is 2-bit-shifted, the video signal is 4. The program current based on the video data is applied in the 1/(2H) period of the first half. Therefore, the video signal is 4 even if the program current is 1, and so the same effect as rendering the reference current four times larger is exerted. In the 1/(2H) period of the second half of the period (a), the reference current ratio is 1 and the predetermined program current Iw is written to the pixel 16a. In this period, the off voltage is applied to the gate signal line 17p, and the switching transistor 11cp is put in the off state. Therefore, no overcurrent (pre-charge current) is applied to the source signal line 18.

Similarly, the video data of the period (b) is 6. If the video data is 2-bit-shifted, the video signal is 24. Therefore, the video signal is 4, and so the same effect as rendering the reference current four times larger is exerted. The program current based on the video data is applied in the 1/(2H) period of the first half. In the 1/(2H) period of the second half of the period (b), the reference current ratio is 1 and the predetermined program current Iw is written to the pixel 16a. In this period, the off voltage is applied to the gate signal line 17p, and the switching transistor 11cp is put in the off state. Therefore, no overcurrent (pre-charge current) is applied to the source signal line 18.

The video data of the period (c) is 1. The video data may be 2-bit-shifted. However, it is not shifted in the embodiment. The video data of the period (b) is 6. The video data of the period (c) is 1. Therefore, as for the change in the video signal, it becomes small, such as 1−6=−5. For that reason, it is necessary to increase the potential of the source signal line on the anode voltage Vdd side. In this case, increasing the program current has an adverse effect. Therefore, the video data is not bit-shifted. The above operation is also applied in the period (e).

The video data of the period (d) is 10. If the video data is 2-bit-shifted, the video signal is 40. Therefore, the same effect as rendering the reference current four times larger because the video signal is 4 is exerted. The program current based on the video data is applied in the 1/(2H) period of the first half. In the 1/(2H) period of the second half of the period (d), the reference current ratio is 1 and the predetermined program current Iw is written to the pixel 16a. In this period, the off voltage is applied to the gate signal line 17p, and the switching transistor 11cp is put in the off state. Therefore, no overcurrent (pre-charge current) is applied to the source signal line 18.

As described above, it is possible, without changing the reference current ratio, to apply the overcurrent to the source signal line 18 by controlling or operating it. Therefore, it is possible to implement the potential change of the source signal line 18 in a short time so as to program the predetermined program current on the pixel 16a (16).

FIG. 459 (2) shows the embodiment in which the period for applying the overcurrent (pre-charge current) is 1/(4H). The other configurations and operations are the same as or similar to those of FIG. 459(1), and so a description thereof will be omitted. It goes without saying that the embodiment of FIGS. 459 may be combined with applying the pre-charge voltage (program voltage) of FIG. 457 (period (c)) and changing the application period of the overcurrent of FIG. 458.

In FIGS. 459, the program current Iw is increased by bit-shifting the video data. However, the present invention is not limited thereto. For instance, it goes without saying that the program current may be increased by multiplying the video signal by a predetermined constant or adding a predetermined constant to it so as to render it as the overcurrent (pre-charge current) As described above, the potential change of the source signal line 18 is rendered earlier by the operation of the overcurrent driving transistor 11ap of the overcurrent pixel 16p and the increase in the program current of the source driver circuit (IC) 14 by bit-shifting the video data, etc. so as to write the predetermined program current Iw to the pixel 16.

It goes without saying that the above matters are also applicable to the circuit configuration, the driving method, and the display panel (display apparatus) shown in FIGS. 127-142, 228-231, 308-313, 324, 328-354, 380-435, 445-467, and the like. Also, it goes without saying that the above matters may be combined with another driving method of the present invention, such as the duty ratio control. The above matters are also applicable to the other embodiments of the present invention described hereunder.

The lighting rate is not considered in the above embodiments. However, it is possible to implement an even better image display by changing or controlling the size of the reference current ratio or the period for increasing the reference current ratio in consideration of the lighting rate. It is because, when the lighting rate is low, there are many pixels of low gradations and the shortage of writing is apt to occur in the current driving method. Inversely, when the lighting rate is high, the program current Iw is large and no shortage of writing occurs. Therefore, there is no need to change the reference current ratio.

FIG. 460 shows the embodiment in which the period for increasing the reference current ratio (application period of the overcurrent) is changed correspondingly to the lighting rate. The reference current ratio is changed with a delay, slowly or with a hysteresis. It is because the flicker occurs. The above was described in relation to the duty ratio control or the reference current ratio control, and so a description thereof will be omitted (refer to the descriptions of FIGS. 93 to 116).

In FIG. 460, at the lighting rate of 0 to 10 percent, the application period of the overcurrent is the 7/(8H) period from the beginning of 1H. Therefore, the potential of the source signal line 18 rises rapidly due to the overcurrent so as to reach the predetermined potential of the source signal line. At the lighting rate of 10 to 25 percent, the application period of the overcurrent is the 3/(4H) period from the beginning of 1H. At the lighting rate of 75 percent or more, the application period of the overcurrent is 0.

FIG. 461 shows the embodiment in which the multiplying factor of the reference current ratio for generating the pre-charge current is changed according to the lighting rate. In FIG. 461, the multiplying factor of the reference current ratio is 20 at the lighting rate of 0 to 10 percent. Therefore, the potential of the source signal line 18 rises rapidly due to the overcurrent so as to reach the predetermined potential of the source signal line. The multiplying factor of the reference current ratio is 10 at the lighting rate of 50 to 75 percent. The multiplying factor of the reference current ratio is gradually reduced from the lighting rate of 75 percent onward, and the multiplying factor is 5 at the lighting rate of 100.

According to the above embodiment, the size of the reference current ratio is fixed (constant) in the 1H period or the predetermined period. However, the present invention is not limited thereto. The output current (program current Iw) is changed by changing the reference current ratio and so on. The main object of the present invention is not to change or control the reference current ratio, but its object is to change the output current.

As shown in FIG. 462, the output current (program current Iw) of the source driver circuit (IC) 14 may be changed in the 1H period. In FIG. 462(a), the output current Iw is changed in the 1/(2H) period of the first half of 1H. The output current is changed from I32 (the current relevant to gradation 32 as to the program current) to I10 (the current relevant to gradation 10 as to the program current). In the next 1H period, the output current is changed from I20 (the current relevant to gradation 20 as to the program current) to I5 (the current relevant to gradation 5 as to the program current). The change in the output current Iw can be implemented by changing the reference current ratio and so on as previously described.

In FIG. 462(b), the output current Iw is fixed in the 1/(4H) period of the first half of 1H and changed in the following 1/(4H) period. The output current is changed from I32 (the current relevant to gradation 32 as to the program current) to I10 (the current relevant to gradation 10 as to the program current). In the next 1H period, the output current is changed from I20 (the current relevant to gradation 20 as to the program current) to I5 (the current relevant to gradation 5 as to the program current). The change in the output current Iw can be implemented by changing the reference current ratio and so on as previously described.

The embodiments of FIGS. 460, 461 and 462 are the embodiments relating to the application of the pre-charge current. It goes without saying, however, that they may be implemented by replacing the pre-charge current with the pre-charge voltage. In FIG. 460 for instance, there is the exemplified embodiment for extending the application period of the pre-charge voltage in the case of the low lighting rate and reducing the application period of the pre-charge voltage or applying no pre-charge voltage in the case of the high lighting rate. In FIG. 461, there is the exemplified embodiment for bringing the pre-charge voltage close to the anode voltage in the case of the low lighting rate and reducing the pre-charge voltage (bringing it close to GND) in the case of the high lighting rate.

According to the above embodiments, the overcurrent (pre-charge current) is applied by the operation of the overcurrent driving transistor 11ap of the overcurrent pixel 16p. However, the present invention is not limited thereto. FIG. 465 shows another embodiment of the present invention. FIG. 464 shows the driving method of selecting N pieces of pixel line in the predetermined period of the first half of 1H (application period of the overcurrent) and selecting one pixel line for writing an original program current in the predetermined period of the second half of 1H so as to write the output current Iw and sequentially hold it.

As for the embodiments hereafter, the period for applying the overcurrent to the source signal line 18 is 1/(2H) to facilitate the description. However, it is not limited thereto as described in FIG. 458. It goes without saying that FIGS. 445 to 462 are applicable to the matters relating to the reference current ratio control and application waveforms. As for the matters relating to the pre-charge voltage or the pre-charge current or the configuration or the operation of the apparatus, the matters described in FIGS. 127 to 142, FIGS. 228 to 231, FIGS. 308 to 313, FIG. 324, FIGS. 328 to 354 and FIGS. 380 to 435 are applicable. Therefore, a description of the matters described above will be omitted hereafter.

FIG. 464 (a1) shows the state in which multiple gate signal lines 17a are selected, and the current from the driving transistor 11a of the pixel line connected to the gate signal lines 17a is applied to the source signal line 18. As previously described, there are the cases where the driving transistor 11a supplies the current to the source signal line 18. However, there are also the cases where the actual operation is performed by the current from the source driver circuit (IC) 14.

FIG. 464 (a2) shows the display state of the screen 144. The display area relevant to the pixel line selected from FIG. 464 (a2) is the non-lit-up area 192. It goes without saying that the embodiments of FIGS. 19 to 27, FIG. 54 and FIGS. 271 to 279 are applicable to the above operation. It goes without saying that they can be implemented in combination.

In FIG. 464 (a1), the source driver circuit (IC) 14 operates at reference current ratio K (K is a value of 1 or more)×N (N is the number of the pixel lines simultaneously selected which is an integer). Therefore, the output current I2 is the program current Iw×N×K corresponding to the video signal. For that reason, I2 is large enough to electrically charge and discharge the parasitic capacitance of the source signal line 18 in a short period.

FIG. 464 (b2) shows the display state of the screen 144. As with FIG. 464 (a2), the display area relevant to the pixel line selected in the first half of 1H is the non-lit-up area 192. It goes without saying that the embodiments of FIGS. 19 to 27, FIG. 54 and FIGS. 271 to 279 are applicable to the above operation. It goes without saying that they can be implemented in combination.

FIG. 464(b1) shows the operation in the predetermined period of the second half of 1H. In the second half of 1H, one pixel line for writing an original program current is selected to write the program current Iw. The source driver circuit (IC) 14 applies the program current Iw to the source signal line 18.

FIG. 465 is a timing chart of the driving method of FIGS. 464. FIG. 465 shows an example in which the number of the pixel lines simultaneously selected is 4. A subscript in a parenthesis of the gate signal line 17a indicates the order of the gate signal line 17a (the gate signal line 17a relevant to the top pixel line on the screen 144 is 17a (1)).

As shown in FIG. 465, the gate signal lines 17a (1), (2), (3) and (4) are selected in the 1/(2H) period of the first half of the period (a) which is the first 1H period, and the current flows into the source signal line 18 from the relevant four pixel lines (the state of FIG. 465(a1)). In the 1/(2H) period of the second half of the period (a), only the gate signal line 17a (1) is selected, and the current program in which the program current Iw is supplied to the relevant one pixel line is implemented (the state of FIG. 465(b1)).

The next 1H period is (b). In the period (b), the selected pixel line is shifted by one pixel line as shown in FIG. 465. The gate signal lines 17a (2), (3), (4) and (5) are selected in the 1/(2H) period of the first half of the period (b) which is the first 1H period, and the current flows into the source signal line 18 from the relevant four pixel lines (the state of FIG. 465(a1)). In the 1/(2H) period of the second half of the period (b), only the gate signal line 17a (2) is selected, and the current program in which the program current Iw is supplied to the relevant one pixel line is implemented (the state of FIG. 465(b1)).

The next 1H period is (c). In the period (c), the selected pixel line is shifted by one pixel line as shown in FIG. 465. The gate signal lines 17a (3), (4), (5) and (6) are selected in the 1/(2H) period of the first half of the period (c) which is the first 1H period, and the current flows into the source signal line 18 from the relevant four pixel lines (the state of FIG. 465(a1)). In the 1/(2H) period of the second half of the period (c), only the gate signal line 17a (3) is selected, and the current program in which the program current Iw is supplied to the relevant one pixel line is implemented (the state of FIG. 465(b1)). The pixel lines sequentially selected by the above operation is shifted and implemented. The other configurations and operations are the same as or similar to the embodiments previously described, and so a description thereof will be omitted.

In the embodiments of FIGS. 464 to 465, the good image display can be implemented by controlling the period for selecting multiple pixel lines correspondingly to the lighting rate as with FIG. 460. FIG. 466 shows the embodiment thereof.

FIG. 466 shows the embodiment in which the period for selecting multiple pixel lines (application period of the overcurrent) is changed correspondingly to the lighting rate. The period is changed with a delay, slowly or with a hysteresis. It is because the flicker occurs. The above was described in relation to the duty ratio control or the reference current ratio control, and so a description thereof will be omitted (refer to the descriptions of FIGS. 93 to 116). As they are described in FIGS. 460 and 461, a description thereof will be omitted.

According to the above embodiments, the overcurrent (pre-charge current) is applied to the source signal line 18 by changing the selected number of pixel lines. It is possible, however, to implement the overcurrent (pre-charge current) even if the selected number of pixel lines is 1. FIG. 467 shows the pixel configuration of that embodiment. Major matters of the pixel configuration of FIG. 467 are described in FIGS. 31 to 34. Therefore, the differences will be mainly described. It goes without saying that the driving method described in FIG. 467 is also applicable to the pixel configurations of FIGS. 35 to 36.

In the pixel configuration of FIG. 467, a transistor 11a2 is the transistor in charge of the overcurrent (Iw1+Iw2 or Iw2). A transistor 11a1 is the transistor for passing the current through the EL element 15. The transistor 11a2 has a larger W than the transistor 11a1 so that the output current becomes larger (Iw2>Iw1).

When passing the overcurrent, the on voltage is applied to gate signal lines 17a1, 17a2 and 17a3 so as to apply the current of Iw2+Iw1 to the source signal line 18. Or else, the on voltage is applied to gate signal lines 17a1 and 17a3 so as to apply the current of Iw2 to the source signal line 18.

When writing the program current to the driving transistor 11a1, the off voltage is applied to gate signal lines 17a1, and the on voltage is applied to gate signal lines 17a2 and 17a3 so as to apply the current of Iw1 to the source signal line 18 (the program current Iw is applied to the source signal line 18 from the source driver circuit (IC) 14).

In the 1/(2H) period of the first half of 1H (not limited to the 1/(2H) period), the driving is performed by the current of Iw1+Iw2 or Iw2. In the 1/(2H) period of the second half, the program current Iw1 is supplied to the relevant one pixel line so as to implement the current program. The pixel lines sequentially selected by the above operation is shifted and implemented. The other configurations and operations are the same as or similar to the embodiments previously described, and so a description thereof will be omitted.

FIG. 456 is a timing chart of the operation of FIG. 467. As shown in FIG. 456, in the 1/(2H) period of the first half of 1H (not limited to the 1/(2H) period), the reference current ratio is 4 and the driving is performed by the current of 4×(Iw1+Iw2) or 4×Iw2 by way of example. In this case, the on voltage is applied to gate signal lines 17a1, 17a2 and 17a3.

In the 1/(2H) period of the second half, the reference current ratio is 1, and the program current Iw1 is supplied to the relevant one pixel line so as to implement the current program. The pixel lines sequentially selected by the above operation is shifted and implemented. The other configurations and operations are the same as or similar to the embodiments previously described, and so a description thereof will be omitted.

The above embodiments are the embodiments relating to the pre-charge current or voltage driving. It is possible, by using this driving method, to correct the white balance displacement due to the change in the luminous efficiency of the EL element 15 at the low gradation. From a technical viewpoint, however, it is the same as the pre-charge driving previously described, and so a description will be given by centering on the differences in particular. Therefore, the contents previously described are applicable to the other configurations, operations, methods and forms. It is also possible to implement it in combination with the contents of the specification of the present invention previously described.

As for the EL element 15, there is a linear relation between the applied current and light emission luminance. However, the luminous efficiency drops when the applied current is small. If the luminous efficiencies of the EL element 15 of the RGB drop at the same ratio, no white balance displacement occurs even at the low gradation. As shown in FIG. 476, however, a balance displacement of the luminous efficiency occurs to the EL element 15 of the RGB at the low gradation in particular.

FIG. 476 shows an example in which the luminous efficiency of green (G) conspicuously drops below 31 gradations. In FIG. 476, the change in the luminous efficiency of red (R) is small, and the change in the luminous efficiency of blue (B) is also relatively small on the low gradation side. However, as the luminous efficiency of green (G) drops significantly, a significant white balance displacement occurs below 31 gradations, and below 15 gradations in particular so that even the white raster display becomes magenta.

As for this problem, either the voltage driving should be implemented or the overcurrent or a padder current should be applied on the low gradation side. To be more specific, the pre-charge voltage or pre-charge current driving should be implemented on the low gradation side (the pre-charge voltage or pre-charge current driving should be implemented at the gradation at which the current passed through the EL element 15 is small).

FIG. 477 has the configuration for applying a padder current Ik in the low gradation region. Refer to FIG. 84 and the description thereof as to the configuration of the padder current. The padder current Ik is controlled by the switches K0 to K3. In the embodiment of FIG. 477, the padder current is K0 to K3 which are 4 bits. Therefore, it is variable or changeable at 16 stages of 0 (none) to 15.

The transistor group for generating the program current Iw consists of 164ah, 164bh, 164ch, 164dh, 164eh, 164fh, 164gh and 164hh which are controlled by the switches D0 to D7. The transistor group for generating the padder current Ik consists of 164ak, 164bk, 164ck, and 164dk which are controlled by the switches K0 to K3.

At gradation 0 for instance, the switch K0 is closed and the padder current in the unit of 1 is added to the program current. At gradation 1, the switch K1 is closed and the padder current in the unit of 2 is added to the program current. At gradation 2 for instance, the switches K0 and K1 are closed and the padder current in the unit of 3 is added to the program current. Similarly, at gradation 7, all the switches K are closed and the padder current in the unit of 15 is added to the program current.

The above embodiment is the embodiment for regularly operating the switches K according to the gradations. However, the present invention is not limited thereto. For instance, there may be an embodiment in which all the switches K are closed at gradation 0 and no padder current is added to the program current. Also, the present invention illustrates the embodiment in which at gradation 1, the switches K0 and K1 are closed and the padder current in the unit of 3 is added to the program current, and at gradation 2 or more, all the switches K are closed and the padder current in the unit of 15 is added to the program current. As for whether or not to add the padder current, it can be easily implemented by controlling the switch 151b2. The other configurations are described in the previous embodiments, and so a description thereof will be omitted.

In FIG. 477, the pre-charge voltage Vpc comprises a low-gradation pre-charge voltage Vpc=VpL such as the voltage V0 and a high-gradation pre-charge voltage Vpc=VpH such as the voltage V255, and is configured to be drivable by switching a contact of the switch 151a between a contact a and a contact b (refer to FIG. 475(b) and the description thereof). It goes without saying that the above can be implemented in combination with the overcurrent driving or the like described before. It goes without saying that the above matters are also applicable to the other embodiments of the present invention.

FIG. 477 shows a circuit of one color of the RGB. In reality, the R, G and B are independently configured. It goes without saying that it is possible, as to the RGB, to vary or change the size, number and bit number of the padder current. The size of the padder current can be implemented easily by changing a reference current Ic2. It goes without saying that the circuit configuration can be simplified by rendering the reference currents Ic1 and Ic2 common. The transistor for outputting the padder current does not need to be the unit transistor but may be varied or changed to be capable of outputting the padder current corresponding to each gradation. It is possible, by applying the padder current to the RGB according to the gradation, to correct (compensate for or adjust) the white balance displacement easily. It goes without saying that the above matters are applicable to the other embodiments of the present invention.

The embodiment of FIG. 477 is the embodiment configuring the output stage of the padder current with the unit transistors. However, the present invention is not limited thereto. For instance, it is also possible, as shown in FIG. 478, to configure it with one or multiple transistors 164k for outputting the padder current Ik. To output the padder current according to the gradation with the configuration of FIG. 478, the reference current Ic2 should be changed.

To change the size of the padder current according to the gradation in FIG. 478, there is also the method of controlling closing time of the switch 151b2 as shown in FIG. 479. The padder current transistors 164k should be configured to be capable of outputting a relatively large padder current. Influence of application of the padder current is little in the case of closing the switch 151b2 for a short period. Influence on the potential change of the source signal line 18 becomes greater in the case of closing the switch 151b2 for a long time.

In FIG. 479, the counter circuit 4682 is reset by the start pulse of 1H, and is counted up by the main clock CLK (refer to FIG. 471). A counter circuit 4782 is controlled by the data on the gradation or gradation change held by the RAM. A counter circuit 4682R controls the red switch (R-SW151b2) of the source driver circuit (IC) 14. A counter circuit 4682G controls the green switch (G-SW151b2) of the source driver circuit (IC) 14. A counter circuit 4682B controls the blue switch (B-SW151b2) of the source driver circuit (IC) 14.

FIG. 479 shows the example in which the period for closing the switch 151b2 of a circuit G is the longest followed by the period for closing the switch 151b2 of a circuit R, and the period for closing the switch 151b2 of a circuit B is the shortest. Therefore, as to the padder current, G is the largest followed by R, and B is the shortest. For that reason, the correction of the white balance displacement of G is the largest, and that of B is the smallest. It is possible to correct the white balance displacements well by controlling the closing time of the switches 151b2 according to the gradation or gradation differences.

As described above, it is possible to control the potential of the source signal line 18 by means of the application period of the padder current because, as the program current is small in the low gradation region, the potential change of the source signal line 18 due to the pre-charge current driving or the pre-charge voltage driving is dominant. To be more specific, padder current driving at the low gradation is the same operation as the pre-charge current driving previously described (refer to FIGS. 471 and 472).

It goes without saying that the embodiment of FIG. 479 is also applicable to the control of the switch 151b2 of FIG. 477. According to the embodiments of FIGS. 477 and 478, the white balance displacement is corrected by the pre-charge current or padder current driving. It goes without saying, however, that the white balance displacement can also be corrected by the pre-charge voltage driving. Since the correction of the white balance displacement by the pre-charge voltage driving is the same as that by the pre-charge current driving described before, a description thereof will be omitted.

In FIG. 478, the switch 151b2 is closed from the beginning of 1H. However, it is not limited thereto. It is possible, from a practical viewpoint, to implement a sufficient correction in whichever period of the 1H period it is closed. It goes without saying that it may be closed or opened multiple times in the 1H period. It goes without saying that the above items are also applicable to the control of the other switches of the present invention.

In FIGS. 477 and 478, the padder current is added to the program current Iw so as to correct the white balance displacement in the low gradation region. However, the present invention is not limited thereto. For instance, it is also possible, as shown in FIG. 480, to configure it separately from the transistor groups 164 (164al to 164hl) for low-gradation correction.

In FIG. 480, the unit transistor groups 164 for low-gradation correction operate in synchronization with the unit transistor groups for generating the program current Iw. The unit transistor groups 164 for low-gradation correction are not limited to being configured by the unit transistors but may also be configured by the transistors of different sizes as described in FIG. 478.

The transistor groups for low-gradation correction of FIG. 480 are controlled by 5 bits of L0 to L4. Therefore, it is possible to correct the 1^{st} gradation to the 31^{st} gradation. In the case of the 1^{st} gradation, the switch D0 is closed and the switch L0 is also closed. Therefore, the terminal 155 has the addition of the unitary current of the transistor group 164ah and unitary current of the transistor group 164al outputted thereto. Similarly, in the case of the second gradation, the switch D1 is closed and the switch L1 is also closed. Therefore, the terminal 155 has the addition of a 2-unit current of the transistor group 164bh and a 2-unit current of the transistor group 164bl outputted thereto. Also in the same way, in the case of the fourth gradation, the switch D2 is closed and the switch L2 is also closed. Therefore, the terminal 155 has the addition of a 4-unit current of the transistor group 164ch and a 4-unit current of the transistor group 164cl outputted thereto. Hereunder, it is the same. In the case of the 32^{nd} gradation, however, the switch D0 to D4 are closed and a 32-unit current corresponding to the program current is outputted to the terminal 155, where the transistor groups 164 on the low-gradation side do not operate. It is because there is no need to correct the white balance displacement at 32 gradations or more as shown in FIG. 476. It goes without saying that the size of the low-gradation current of the RGB can be implemented by differentiating or adjusting the reference current Id1 among the R, G and B. The other configurations are the same as those of the other embodiments of the present invention, and so a description thereof will be omitted.

It goes without saying that the above embodiment can be combined with the embodiment of FIG. 479. According to the embodiment of FIG. 480, it is operated by synchronizing the switches Dn with the switches Ln at the low gradation. However, it is not limited thereto. It goes without saying that only the switches Ln (L0 to L4 in FIG. 480) may be operated at the low gradation. At the intermediate or higher gradations of 32 gradations or more, all the IN switches are closed and the switches Dn are closed according to the gradations. In this case, it becomes a one-point broken line gamma as shown in FIG. 481. In FIG. 481, the one-point broken line gamma is only implemented as to blue (B). It is not implemented as to red (R) and blue (B). As a matter of course, the one-point broken line gamma may be implemented as to the RGB. It is not limited to the one-point broken line gamma but may be multi-point broken line gamma of two or more points. As this configuration is also described in FIG. 84, a description thereof will be omitted.

It is possible to compensate for (correct) the white balance displacement of the low gradation not only by the overcurrent driving or the padder current driving of FIGS. 477 to 480 but also by the pre-charge voltage driving. FIG. 482 is the embodiment thereof. In FIG. 482, the voltage driving is implemented below gradation 3. Therefore, the periods of (b), (c), (d), (e) and (g) are below gradation 3, and so the pre-charge voltage is applied for the period of 1H. It is not limited to applying the pre-charge voltage for the entire period of 1H. It goes without saying that the pre-charge voltage (program voltage) may also be implemented for a part of the period of 1H.

In FIG. 483, the white balance displacement of the low gradation is corrected by the overcurrent driving (pre-charge current driving). In FIG. 483, the overcurrent driving is implemented below gradation 3. However, it is the example in which the direction of the overcurrent is the discharge current direction. Therefore, the periods of (b), (c), (d), (e) and (g) are below gradation 3, and so the pre-charge voltage is applied for the period of 1H. Therefore, the potential of the source signal line 18 rises linearly in the direction of the anode voltage Vdd. It is not limited to applying the pre-charge current over the entire period of 1H. It goes without saying that the pre-charge voltage (+program current) may also be implemented in a part of the period of 1H.

In FIG. 484, after the pre-charge voltage is applied, the white balance displacement of the low gradation is corrected by the overcurrent driving (pre-charge current driving). In FIG. 484, the driving method of the present invention is implemented below gradation 3. Therefore, the periods (b), (c), (d), (e) and (g) are below gradation 3, and so the voltage V0 corresponding to the gradation is applied (the pre-charge voltage is applied) in the first period of 1H. The pre-charge current is applied simultaneously or after applying the pre-charge voltage. However, the direction of the pre-charge current is the direction of the sink current (absorption current). Therefore, in the periods (b), (c), (d), (e) and (g), the potential of the source signal line 18 becomes the voltage V0 at the beginning of 1H and is reduced by the pre-charge current. The potential of the source signal line 18 is reduced linearly in the direction of GND. It is not limited to applying the pre-charge current over the entire period of 1H. It goes without saying that the pre-charge current (+program current) may also be implemented in a part of the period of 1H.

As described above, in the case of the correction of the white balance displacement of the low gradation, it is possible to improve it and implement a good white balance in the entire gradation range by the overcurrent driving, pre-charge voltage (program voltage) driving and padder current driving of the present invention or combination thereof. It goes without saying that the above embodiment is also applicable to the other embodiments of the present invention.

It was described that whether or not to apply the overcurrent (pre-charge current or discharge current) and padder current should be determined sequentially in FIGS. 381 to 422, FIGS. 445 to 467 and FIGS. 477 to 484. However, the present invention is not limited thereto. For instance, in the case of interlace driving, it is possible to apply the overcurrent (pre-charge current or discharge current) to the odd-numbered pixel lines in the first field and apply the overcurrent (pre-charge current or discharge current) to the even-numbered pixel lines in the second field.

There is also an exemplified driving method of applying the overcurrent (pre-charge current or discharge current) to each pixel line in an arbitrary frame and applying no overcurrent (pre-charge current or discharge current) in the next frame. It is also possible to perform the driving to apply the overcurrent (pre-charge current or discharge current) randomly to each pixel line and apply the overcurrent (pre-charge current or discharge current) averagely to each pixel in multiple frames.

There is also an exemplified driving method of applying the overcurrent (pre-charge current or discharge current) only to specific low-gradation pixels. There is also an exemplified driving method of applying the overcurrent (pre-charge current or discharge current) only to specific high-gradation pixels. There is also an exemplified configuration for applying the overcurrent (pre-charge current or discharge current) only to specific intermediate-gradation pixels. There is also an exemplified configuration for applying the overcurrent (pre-charge current or discharge current) to the pixels in a specific gradation range from the potential of the source signal line (image data) preceding by 1H or multiple Hs.

It is described that the overcurrent (pre-charge current) in the overcurrent driving (pre-charge current driving) in FIGS. 381 to 422 and FIGS. 477 to 484 changes, adjusts, varies or renders variable the reference current, duty ratio, pre-charge voltage (synonymous with or similar to the program voltage) and gamma curve by means of the image (video) data, lighting rate, current passing through the anode (cathode) terminal and panel temperature. However, it is not limited thereto. For instance, it goes without saying that the reference current, duty ratio, pre-charge voltage (synonymous with or similar to the program voltage) and gamma curve maybe changed, adjusted, varied, rendered variable or controlled by predicting or estimating the change ratio or change in the image (video) data, lighting rate, current passing through the anode (cathode) terminal and panel temperature. It also goes without saying that the frame rate may be changed or varied.

For instance, the size of the overcurrent (pre-charge current), application time and number of times of application may be in conjunction with or in combination with the lighting rate, duty ratio and reference current of FIGS. 93 to 116, 252 and 269. They may be also in conjunction with or in combination with the pre-charge voltage control of FIGS. 117, 236, 238 and 257. They may be also in conjunction with or in combination with the anode voltage control of FIGS. 122, 123, 124, 125 and 280. Of course, they may be also in combination with the voltage driving (voltage pre-charge A) described in FIGS. 127 to 142, 308 to 313 and 332 to 354. Further, they may be in conjunction with or in combination with the reference current control of the RGB of FIGS. 149, 150, 151, 152 and 153. Also they may be combined with the concepts of temperature control of FIGS. 253 and 254. They may be also in conjunction with or in combination with the gamma control of FIG. 256. Further, they may be in conjunction with or in combination with the frame rate control (FRC) described in FIGS. 259 and 313. They may be also in conjunction with or in combination with the number of gate signal lines to be selected of FIGS. 276 to 277. Further, they may be in conjunction with or in combination with the gate voltage control (Vgh, Vgl) described in FIGS. 315 and 318. Further, they may be in conjunction with the division number control.

According to the present invention, the pre-charge current or pre-charge voltage driving is implemented. For instance, to implement 1024 gradations with the source driver circuit (IC) 14 of 8 bits (256 gradations), it should be combined with 4FRC as described in FIGS. 313. Therefore, as to the 2^{nd} gradation of the 1024 gradations, the source driver circuit (IC) 14 of 256 gradations displays the output of the 0^{th} gradation and the output of the 1^{st} gradation in combination. Therefore, in the case of FRC driving, the source signal line 18 has the voltages of the 0 gradation (pre-charge voltage and the program voltage or program current of the 1^{st} gradation) alternately applied thereto at each 1H. As this region is the low gradation region, the pre-charge driving must be implemented at the 1^{st} gradation. The pre-charge driving is also implemented by the raster display. If the pre-charge driving is implemented, it gets into the voltage driving state even in the case of the current driving so that uniformity of the display is reduced. In the case of the raster display, no shortage of writing occurs even in the low gradation region, and so a uniform display can be implemented just by the program current. It is not desirable to reduce the uniformity by implementing the pre-charge driving.

To solve this problem, the present invention does not implement the pre-charge driving in the case of adjacent gradation outputs (as for the source driver circuit (IC) 14 of 256 gradations, the output of the 0^{th} gradation and the output of the 1^{st} gradation are the adjacent outputs, and the output of the 1^{st} gradation and the output of the 2^{nd} gradation are also the adjacent outputs) when implementing the FRC driving. To be more specific, the pre-charge driving (voltage pre-charge, current pre-charge) is not implemented when the difference in the output applied to the source signal line 18 is only one gradation. It is because it determines that there is no change in the raster display or the image due to the FRC and the uniform display is implemented just by the current driving. In the case of the difference of one gradation, the FRC is implemented so that the voltage driving is implemented on the entire screen on implementing the pre-charge driving. And there is a high possibility that the characteristic variations of the driving transistor 11a of the pixels 16 will be displayed on the screen 144.

The FRC is a technique for implementing the gradation display between the adjacent gradations which are combined. For instance, it is possible to implement approximately 256-gradation display if 4FRC is implemented by 6-bit display (64 gradations). For instance, it is possible, by this display method, to display 7 gradations between the 1^{st} gradation and the 2^{nd} gradation (adjacent gradations) by combining the 1^{st} gradation and the 2^{nd} gradation. In the same way, it is possible, by this display method, to display 7 gradations between the 2^{nd} gradation and the 3^{rd} gradation (adjacent gradations) by combining the 1^{st} gradation and the 2^{nd} gradation.

When there is the difference of 2 gradations or more, the pre-charge driving (voltage pre-charge, current pre-charge) is implemented (it is implemented especially in the low gradation region). As for the source driver circuit (IC) 14 of 256 gradations for instance, it is when the output applied to the source signal line 18 changes from the 0^{th} gradation to the 2^{nd} gradation. It is also when the output applied to the source signal line 18 changes from the output of the 1^{st} gradation to the 3^{rd} gradation. When changing by 2 gradations or more, it is determined as the gradation change over the FRC so as to solve the shortage of writing by the pre-charge driving. The above determination is made by the controller circuit (IC) 760. To be more specific, it is because the FRC driving is not implemented in the case of the difference of 2 gradations or more.

To further describe the embodiments, the 6^{th} gradation of 1024 gradations is displayed by the output of the 1^{st} gradation and the output of the 2^{nd} gradation in the source driver circuit (IC) 14 of 256 gradations. The source signal line 18 has the output of the 1^{st} gradation and the output of the 2^{nd} gradation applied thereto alternately or in constant periods from the source driver circuit (IC) 14 of 256 gradations.

Thus, no pre-charge driving is implemented when the video data applied to the source signal line 18 is equivalent to one gradation. To be more specific, no pre-charge driving (voltage pre-charge, current pre-charge) is implemented when there is only the difference of one gradation in the gradation not considering the FRC (256 gradations according to this embodiment) as to the output applied to the source signal line 18. It is because it is determined that no change occurs to the raster display or the image due to the FRC and the uniform display is implemented just by the current driving.

When there is the difference of 2 gradations or more, the pre-charge driving (voltage pre-charge, current pre-charge) is implemented. It is implemented especially in the low gradation region. As for the source driver circuit (IC) 14 of 256 gradations for instance, there is an exemplified case where the output applied to the source signal line 18 changes from the 1^{st} gradation to the 3^{rd} gradation or more. There is no need to implement the pre-charge driving in the low gradation region. It is because the writing current is large.

As described above, the pre-charge driving is implemented as required when the number of gradations applied to the source signal line 18 changes by 2 gradations or more at this gradation (256 gradations in this embodiment) on implementing the FRC. However, the present invention is not limited thereto. It goes without saying that the pre-charge driving may be implemented as required when the number of gradations applied to the source signal line 18 changes by 2 gradations or more even when not implementing the FRC.

However, the pre-charge driving may be implemented even in the case where the change in the adjacent pixel line (change in the signal level applied to the source signal line 18) is the difference of one gradation. For instance, in the case of displaying a natural image, the characteristic variations of the driving transistor 11a of the pixels 16 are not noticeable (they are noticeable in the case of a pattern display such as the white raster) even if the pre-charge driving is implemented. Therefore, whether or not to implement the pre-charge driving should be decided by determining the display image with the controller circuit (IC) 760.

It goes without saying that, if the number of the changing gradations out of the gradations after nFRC is C, the pre-charge driving may be implemented as required in the case where C/n is larger than 1. In the case of displaying 1024 gradations with 4FRC, the pre-charge driving is not implemented if the number of the gradations changing at 1024 gradations is 4 (C=4) and consequently 4/4=1. If the number of the gradations changing at 1024 gradations is 5 or more (C=5 or more) and consequently 5/4>1, the pre-charge driving is implemented as required.

In the embodiment hereinbefore, it has been described that the pre-charge driving is implemented as required in the case where C/n is larger than 1, however, it may be described that the pre-charge driving is implemented as required in the case where C/n is larger than K. The value of K is changed according to the lighting rate. For instance, in the case of displaying 1024 gradations with 4FRC, it is K=4 when the lighting rate is 70 percent or more, and it is 16/4=4=K when the number of the gradations changing at 1024 gradations is 16 (C=16) so that the pre-charge driving may be implemented. In the case of C=less than 16, the pre-charge driving is not implemented. Also, in the case of displaying 1024 gradations with 4FRC, it is K=2 when the lighting rate is 20 percent or more, and it is 8/4=2=K when the number of the gradations changing at 1024 gradations is 8 (C=8) so that the pre-charge driving may be implemented. In the case of C=less than 8, the pre-charge driving is not implemented.

As for the aforementioned embodiment, it goes without saying that the pre-charge driving may be implemented when the output applied to the source signal line 18 changes from the low gradation to the high gradation such as the case of changing from the 1^{st} gradation to the 3^{rd} gradation or higher and when it changes from the high gradation to the low gradation such as the case of changing from the 3^{rd} gradation to the 1^{st} gradation or lower or changing from the 10^{th} gradation to the 8^{th} gradation or lower. There is no need to implement the pre-charge driving in the high gradation region of a predetermined gradation or higher. It is because the writing current is large.

The above is also applicable to the other embodiments of the present invention. It goes without saying that the above can be implemented in combination with the other embodiments of the present invention.

The pre-charge voltage (synonymous with or similar to the program voltage) driving described in FIGS. 127 to 143, 293, 311, 312, 339 to 344 and 477 to 484 may be in combination with the overcurrent (pre-charge current or discharge current) described in FIGS. 381 to 422. For instance, there is an exemplified method whereby, in the case where the video data applied to a predetermined pixel satisfies predetermined conditions, the pre-charge voltage (synonymous with or similar to the program voltage) is applied, then the overcurrent (pre-charge current or discharge current) is applied sequentially and the program current is applied in the remaining 1H period.

In the case of the interlaced driving, there is an exemplified driving method of applying the pre-charge voltage (synonymous with or similar to the program voltage) to the odd-numbered pixel lines in the first field and applying the overcurrent (pre-charge current or discharge current) to the even-numbered pixel lines the second field.

There is also an exemplified driving method of applying the pre-charge voltage (synonymous with or similar to the program voltage) or the overcurrent (pre-charge current or discharge current) in an arbitrary frame and applying neither pre-charge voltage (synonymous with or similar to the program voltage) nor the overcurrent (pre-charge current or discharge current) in the next frame.

It is also possible to perform the driving to apply the pre-charge voltage (synonymous with or similar to the program voltage) and/or the overcurrent (pre-charge current or discharge current) randomly to each pixel line and apply the pre-charge voltage (synonymous with or similar to the program voltage) or the overcurrent (pre-charge current or discharge current) averagely to each pixel in multiple frames.

There is also an exemplified driving method of applying the pre-charge voltage (synonymous with or similar to the program voltage) only to specific low-gradation pixels and applying the overcurrent (pre-charge current or discharge current) to the intermediate-gradation pixels.

There is also an exemplified driving method of applying the pre-charge voltage (synonymous with or similar to the program voltage) only to specific high-gradation pixels and applying the pre-charge voltage (synonymous with or similar to the program voltage) and the overcurrent (pre-charge current or discharge current) to the low-gradation pixels based on a determination on a timely basis.

There is also an exemplified configuration (method) for applying the overcurrent (pre-charge current or discharge current) in the case where the difference from specific image data preceding by 1H or multiple Hs is large and applying the pre-charge voltage (synonymous with or similar to the program voltage) in the case of 0 gradation or the low gradation.

There is also an exemplified configuration (method) for applying the pre-charge voltage (synonymous with or similar to the program voltage) or the overcurrent (pre-charge current or discharge current) to the pixels in a specific gradation range from the potential of the source signal line (image data) preceding by 1H or multiple Hs.

As described above, it goes without saying that, as for the driving method of the present invention, the driving methods described in this specification may be combined and used. For instance, it is possible to combine the pre-charge voltage (synonymous with or similar to the program voltage) driving described in FIGS. 127 to 143, FIG. 293, FIG. 311, FIG. 312 and FIGS. 339 to 344 with the overcurrent (pre-charge current or discharge current) driving described in FIGS. 381 to 422 and FIGS. 477 to 484.

As for the current program method, the parasitic capacitance of the source signal line 18 is the problem. The parasitic capacitance of the source signal line is not even in the display screen 144. In general, the parasitic capacitance is large in a peripheral part of the screen and small in a central part thereof. This is supposedly because, as shown in FIG. 524, the parasitic capacitance is formed by being changed according to placement of the source signal line 18 to be wired from the source driver circuit (IC) 14 to the display area 144. There are the cases where the source signal line 18 is placed obliquely between the source driver circuit (IC) 14 and the display area 144 (area A of FIG. 524).

Source signal lines 18f and 18g in the central part of the display area 144 are placed linearly from the source driver circuit (IC) 14. Therefore, the parasitic capacitances of the source signal lines 18f and 18g become relatively small. Source signal lines 18a, 18b, 18m and 18n in the peripheral part of the display screen 144 are placed obliquely from the source driver circuit (IC) 14. Therefore, the parasitic capacitances of the source signal lines 18a, 18b, 18m and 18n become larger than those of the source signal lines 18f and 18g.

If the parasitic capacitance of the source signal line 18 is different, the program current Iw on the current program changes correspondingly to a source signal line position. In particular, this phenomenon occurs in low gradation region. To be more specific, a luminance inclination occurs from the central part (line symmetry) to the peripheral part of the screen.

As shown in FIG. 524, the present invention forms an insulating film 32 on the source signal line 18 for this problem, and the capacitor electrode 5191 (refer to FIG. 519) is formed on the insulating film 32. As described in FIG. 519, it goes without saying that the capacitor electrode 5191 may also be formed in the lower layer of the source signal line 18.

FIGS. 522 are plan views of a location A of FIG. 524. A location k of FIG. 522 (a) is the central part of the display panel (refer to a position k of FIG. 524). FIG. 523(b) shows a sectional view (kk) of the location k. A location j of FIG. 522(a) is the peripheral part of the display panel (refer to a position j of FIG. 524). FIG. 523(a) shows a sectional view (jj¹) of the location j.

As is apparent in FIGS. 523, the overlap of the capacitor electrode 5191 and the source signal line 18 of FIG. 523(b) is larger than the overlap of the capacitor electrode 5191 and the source signal line 18 of FIG. 523(a). Therefore, the capacitor capacity of FIG. 523(b) is larger than that of FIG. 523(a). Thus, the capacitor capacity of a point k of FIG. 522 (a) is larger than that of a point j. It is possible to match the capacitor capacity of a point k of FIG. 524 with that of a point j by adopting or implementing the above configuration. Therefore, no luminance inclination occurs to the screen 144 even during the current program driving at the low gradation.

The above embodiments have the configuration for rendering the potential of the capacitor electrode 5191 constant. It is possible to change the capacitor capacity according to the position of the source signal line 18 not only by the above embodiments but also by the configuration of FIG. 522(b). FIG. 522(b) is an equivalent circuit diagram of FIG. 522(a). As an L portion of FIG. 522(a) is made to be thin, it is put in the state of having the resistors R equivalently connected (FIG. 522(b)).

Therefore, if the voltage is applied to a point B of FIG. 522(b), a potential inclination occurs from the point B to a point A and from the point B to a point C. Thus, the capacitor capacity increases around the point B, and relatively decreases at the point A and point C against the point B. Therefore, the total capacitor capacity of the point j (the parasitic capacitance of the source signal line 18 is large) matches with that of the point k (the parasitic capacitance of the source signal line 18 is small) in FIG. 524.

It is possible to vary or change the capacitor capacity viewing each source signal line 18 from the source driver circuit (IC) 14 according to the positions for applying the voltage such as the points A, C and B of FIG. 522(b). Therefore, it is possible to correct the luminance inclination of the screen and purposely generate the luminance inclination.

In FIGS. 522, the capacitor electrode 5191 is formed on the source signal line 18. However, the present invention is not limited thereto. The present invention is intended to configure it so that, on viewing each source signal line 18 from the source driver circuit (IC) 14, the parasitic capacitance (not limited to the parasitic capacitance but may be any capacitor component) becomes approximately matching or as equal as possible among the source signal lines 18.

Therefore, as in FIGS. 522, there is an example of the configuration for forming or placing the capacitor electrode 5191 on the source signal line 18. It is also possible to form a first electrode between the adjacent source signal lines 18 and set the formed first electrode at the predetermined potential so as to configure the capacitor by electromagnetically coupling it between the source signal line 18 and the first electrode. It is possible to equalize the capacitor capacity of the source signal lines 18 by changing the form and position of the first electrode between the central part and the peripheral part of the screen 144.

It is possible to form a groove between the adjacent source signal lines 18 and change or adjust the electromagnetic coupling of the adjacent source signal lines 18 via a substrate 30. As the groove is extended, the electromagnetic coupling between the adjacent source signal lines becomes smaller, and the capacitor capacity between the source signal lines 18 is reduced. As the groove is deepened, the electromagnetic coupling between the adjacent source signal lines becomes smaller, and the capacitor capacity between the source signal lines 18 is reduced. Inversely, as the groove formed on the substrate 30 is shortened, the electromagnetic coupling between the adjacent source signal lines becomes relatively larger, and the capacitor capacity between the source signal lines 18 is increased. As the groove is shallowed, the electromagnetic coupling between the adjacent source signal lines becomes relatively larger, and the capacitor capacity between the source signal lines 18 is relatively increased.

It is described in FIGS. 519 and 512 that the capacitor electrode 5191 is formed. However, it is not limited thereto. For instance, it is possible to form the capacitor electrode 5191 with a cathode electrode 36. Or else, it is possible to form the capacitor electrode 5191 in a formation process of the cathode electrode 36.

As described above, the current driving method is characterized in that the display panel (array) is configured to render the parasitic capacitance of the source signal lines 18 approximately even. It is also characterized in that the parasitic capacitance is controllable or variable. It is also characterized by the driving methods of the display panel (array).

Hereunder, a description will be given as to the EL display panel or the EL display apparatus of the present invention or the apparatus using the driving methods thereof. The following apparatus implements the apparatus or methods of the present invention previously described. FIG. 126 is a plan view of a cell phone which is an example of an information terminal. An antenna 1261, numeric keys 1262, etc. are mounted on a casing 1263. Reference numerals 1262 and the like denote a display color switch key, power key, and frame rate switch key.

The key 1262 may be configured to switch among color modes as follows: pressing it once enters 8-color display mode, pressing it again enters 4096-color display mode, and pressing it again enters 260,000-color display mode. The key is a toggle switch which switch among color display modes each time it is pressed. Incidentally, a display color change key may be provided separately. In that case, three (or more) keys 1262 are needed.

In addition to a push switch, the key 1262 may be a slide switch or other mechanical switch. Speech recognition may also be used for switching. For example, the switch may be configured such that display colors on the display screen 144 of the display panel will change as the user speaks a phrase such as “high-definition display,” “4096-color mode, ” or “low-color display mode” into the phone. This can be implemented easily using existing speech recognition technology. Display colors may be switched by implementing the FRC or the pre-charge driving. Embodiment of the FRC or the pre-charge driving described hereinbefore is omitted.

Also, display colors may be switched electrically. It is also possible to employ a touch panel which allows the user to make a selection by touching a menu presented on the display part 144 of the display panel. Besides, display colors may be switched based on the number of times the switch is pressed or based on a rotation or direction as is the case with a click ball.

A key which changes frame rate or a key which switches between moving pictures and still pictures many be used in place of the display color switch key 1262. A key may switch two or more items at the same time: for example, among frame rates and between moving pictures and still pictures. Also, the key may be configured to change the frame rate gradually (continuously) when pressed and held. For that, among a capacitor C and a resistor R of an oscillator, the resistor R can be made variable or replaced with an electronic regulator. Alternatively, a trimmer capacitor may be used as a capacitor C of the oscillator. Such a key can also be implemented by forming a plurality of capacitors in a semiconductor chip, selecting one or more capacitors, and connecting the capacitors in parallel.

As for the display panel (display apparatus) of the present invention, a brightness adjustment is implemented by the duty ratio control (refer to FIGS. 19 to 27 and FIG. 54) or the reference current ratio control (refer to FIGS. 60, 61, 64 and 65). In particular, the configuration of the reference current ratio control circuit described in FIG. 65 is desirable because it allows, by switching a switch 642, to control or adjust the brightness of the display screen 144 linearly while maintaining the white balance. The brightness adjustment may be either software-controlled by the controller circuit (IC) 760 or adjusted by a touch switch for making a selection by touching a menu displayed on the display portion 144 of the display panel. It may also be the method of detecting intensity of outside light with a photosensor and adjusting it automatically. It goes without saying that the above is also applicable to contrast control. It goes without saying that the above is also applicable to the duty ratio control.

An important function for the display panel is to be capable of displaying the images in multiple formats. For instance, it is necessary for a digital video camera (DVC) to be capable of displaying NTSC and PAL images. Hereunder, a description will be given as to the method of displaying the images in multiple formats on one panel. To facilitate the description, the following description will be given as to the case where the display panel is a QVGA panel of horizontal 320 RGB×vertical 240 dots, and the NTSC and PAL images are displayed on the QVGA panel of this pixel number.

FIG. 154 is a sectional view of a view finder according to an embodiment of the present invention. It is illustrated schematically for ease of explanation. Besides, some parts are enlarged, reduced, or omitted. For example, an eyepiece cover is omitted in FIG. 154. The above items also apply to other drawings.

Inner surfaces of a body 1263 are dark- or black-colored. This is to prevent stray light emitted from an EL display panel (EL display apparatus) 1264 from being reflected diffusely inside the body 1263 and lowering display contrast. A phase plate (λ/4) 38, polarizing plate 39, and the like are placed on an exit side of the display panel. This has also been described with reference to FIGS. 3 and 4.

An eye ring 1541 is fitted with a magnifying lens 1542. The observer focuses on a display screen 144 on the display panel 1264 by adjusting the position of the eye ring 1541 in the body 1263.

If a convex lens 1543 is placed on the exit side of the display panel 1264 as required, principal rays entering the magnifying lens 1542 can be made to converge. This makes it possible to reduce the diameter of the magnifying lens 1542, and thus reduce the size of the view finder.

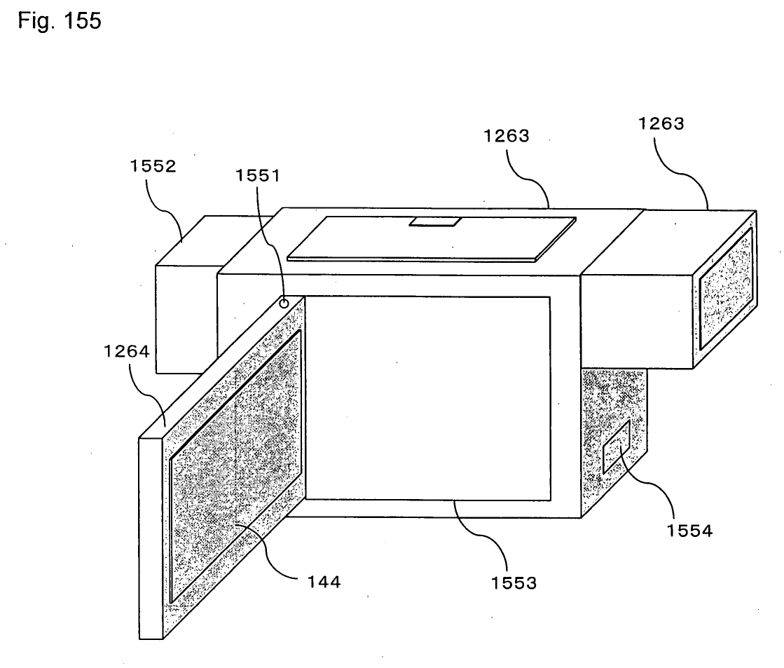

FIG. 155 is a perspective view of a video camera. A video camera has a taking (imaging) lens 1552 and a video camera body 1263. The taking lens 1552 and view finder 1263 are mounted back to back with each other. The view finder 1263 (see also FIG. 154) is equipped with an eyepiece cover. The observer views the display screen 144 on the display panel 1264 through the eyepiece cover.

The EL display panel according to the present invention is also used as a display monitor. The display part 144 can pivot freely on a point of support 1551. The display part 144 is stored in a storage compartment 1553 when not in use.

A switch 1554 is a changeover switch or control switch and performs the following functions. The switch 1554 is a display mode changeover switch. The switch 1554 is also suitable for cell phones and the like. Now the display mode changeover switch 1554 will be described.

The drive methods according to the present invention include the one that passes an N times larger current through EL elements 15 to illuminate them for a period equal to 1/M of 1F. By varying this illumination period, it is possible to change brightness digitally. For example, designating that N=4, a four times larger current is passed through the EL elements 15. If the illumination period is 1/M, by switching M among 1, 2, 3, and 4, it is possible to vary brightness from 1 to 4 times. Incidentally, M may be switched among 1, 1.5, 2, 3, 4, 5, 6, and so on.

The switching operation described above is used for cell phones, monitors, etc. which display the display screen 144 very brightly at power-on and reduce display brightness after a certain period to save power. It can also be used to allow the user to set a desired brightness. For example, the brightness of the screen is increased greatly outdoors. This is because the screen cannot be seen at all outdoors due to bright surroundings. However, the EL elements 15 deteriorate quickly under conditions of continuous display at high brightness. Thus, the screen 50 is designed to return to normal brightness in a short period of time if it is displayed very brightly. A button which can be pressed to increase display brightness should be provided, in case the user wants to display the screen 50 at high brightness again.

Thus, it is preferable that the user can change display brightness with the button switch 1554, that the display brightness can be changed automatically according to mode settings, or that the display brightness can be changed automatically by detecting the brightness of extraneous light. Preferably, display brightness settings such as 50%, 60%, 80%, etc. are available to the user.

Preferably, the display screen 144 employs Gaussian display. That is, the center of the display screen 144 is bright and the perimeter is relatively dark. Visually, if the center is bright, the display screen 144 seems to be bright even if the perimeter is dark. According to subjective evaluation, as long as the perimeter is at least 70% as bright as the center, there is not much visual difference. Even if the brightness of the perimeter is reduced to 50%, there is almost no problem. The self-luminous display panel according to the present invention generates a Gaussian distribution from top to bottom of the screen using the N-fold pulse driving described above (a method which passes an N times larger current through EL elements 15 to illuminate them for a period equal to 1/M of 1F).

Specifically, the value of M is increased in upper and lower parts of the screen and decreased in the center of the screen. This is accomplished by modulating the operating speed of a shift register of the gate driver circuits 12. The brightness at the left and right of the screen is modulated by multiplying video data by table data. By reducing peripheral brightness (at an angle of view of 0.9) to 50% through the above operation, it is possible to reduce power consumption by 20% compared to brightness of 100%. By reducing peripheral brightness (at an angle of view of 0.9) to 70%, it is possible to reduce power consumption by 15% compared to brightness of 100%.

It goes without saying that the Gaussian distribution can also be implemented by changing the reference current (for instance, increasing the reference current ratio in the central part of the screen and reducing it at the top and bottom of the screen), changing the duty ratio (for instance, increasing the duty ratio in the central part of the screen and reducing it at the top and bottom of the screen) and changing the pre-charge current or the pre-charge voltage.

Preferably a changeover switch or the like is provided to enable and disable the Gaussian display. This is because the perimeter of the screen cannot be seen at all outdoors if the Gaussian display is used. Thus, it is preferable that the user can change display brightness with the button switch, that the display brightness can be changed automatically according to mode settings, or that the display brightness can be changed automatically by detecting the brightness of extraneous light. Preferably, display brightness settings such as 50%, 60%, 80%, etc. are available to the user.

Liquid crystal display panels generate a fixed Gaussian distribution using a backlight.

As described in FIG. 3, the cathode electrode 36 is formed or configured by a thin film made of aluminum. The thin film made of aluminum has a mirror property and a high reflectance so that it is useable as a mirror. Therefore, the EL display panel can have its surface used for the image display as the screen 144 and its backside used as the mirror. However, a desiccant 37 is placed in the peripheral part of an area of use so as not to shield the mirror from the light from the cathode electrode 36.

FIG. 325 is a sectional view of the display apparatus of the present invention. FIG. 325 shows the display apparatus of the present invention configured to have its surface used as the image display screen 144 (viewed from a direction B) and used as the mirror when viewed from a direction A. A display panel 1264 is configured to be rotatable on a supporting point 1551. Therefore, it is easy to use it as the mirror or as a monitor depending on a holding angle of the display panel 1264.

FIGS. 326 show a second embodiment of the display apparatus useable as the mirror or as the monitor. FIG. 326(a) shows a state of using the EL display panel as the monitor, and FIG. 326(c) shows a state of using it as the mirror. FIG. 326(b) shows a state of change from the monitor using state to the mirror using state or from the mirror using state to the monitor using state.

In FIG. 326(a), the display panel 1264 is stored in a storage portion 1561 of the display panel 1264. As shown in FIG. 326(b), when using it as the mirror, the display panel 1264 is taken out of the storage portion 1561 and rotated on the supporting point 1551 so as to turn it over. Thereafter, the display panel 1264 is stored in the storage portion 1561 with its mirror (cathode 36 surface) upside (FIG. 326(c)). As shown in FIG. 326(b), when using it as the monitor, the display panel 1264 is taken out of the storage portion 1561 and rotated on the supporting point 1551 so as to turn it over. Thereafter, the display panel 1264 is stored in the storage portion 1561 with its picture electrode 35 upside (FIG. 326(a)). The above embodiment is the case where the light is taken out in the direction B as shown in FIG. 3. It goes without saying that, in the case where the light is taken out on the side A as shown in FIG. 4, the relation becomes reverse.

A fixed frame rate may cause interference with illumination of an indoor fluorescent lamp or the like, resulting in flickering. Specifically, if the EL elements 15 operate on 60-Hz alternating current, a fluorescent lamp illuminating on 60-Hz alternating current may cause subtle interference, making it look as if the screen were flickering slowly. To avoid this situation, the frame rate can be changed. The present invention has a capability to change frame rates. Also, it allows the value of N or M to be changed in N-fold pulse driving (a method which passes an N times larger current through EL elements 15 to illuminate them for a period equal to 1/M of 1F) (Refer to FIGS. 2, 3 , 54(a) to (c), etc.).

It is desirable, as shown in FIG. 317, to have a configuration in which the number of divisions of the screen is variable according to the frame rate. When the frame rate is low, the number of divisions (the screen 144 is configured by dividing the non-lit-up area 192 into a plurality) is increased as shown in FIG. 54(c). When the frame rate is high, the non-lit-up area 192 is inserted into the screen 144 collectively as shown in FIG. 54(a).

For instance, the transmission frame rate of a terrestrial digital mobile television is 15 Hz. In this case, the frame rate is low and so it is necessary to divide the non-lit-up area 192 in to a plurality as shown in FIG. 54(c). However, the transmission frame rate of a terrestrial analog television at present is 60 Hz. In this case, the frame rate is high and so it is desirable to insert the non-lit-up area 192 collectively as shown in FIG. 54(a) so as to secure movie display performance. To be more specific, the number of divisions is changed or rendered variable according to the use or received signal.

In FIG. 317, the number of divisions is 1 at the frame rate of 60 to 45 Hz (there is one non-lit-up area 192 (the state of FIG. 54(a)). It is the embodiment in which the number of divisions is 10 at the frame rate below 45 Hz (the state of 10 non-lit-up areas 192). As for the number of divisions, it is desirable that the number of divisions be changeable, variable and settable automatically, manually or programmably not only according to the frame rate but also according to peripheral luminance (brightness), image contents (still image, dynamic image) and uses of the apparatus (mobile, stationary). It goes without saying that the above is also applicable to the other embodiments of the present invention.

The above capabilities are implemented by way of the switch 1554. The switch 1554 switches among the above capabilities when pressed more than once, following a menu on the screen 144.

Incidentally, the above items are not limited to cell phones. Needless to say, they are applicable to television sets, monitors, etc. Also, it is preferable to provide icons on the display screen to allow the user to know at a glance what display mode he/she is in. The above items similarly apply to the following.

The EL display apparatus and the like according to this embodiment can be applied not only to video cameras, but also to digital cameras such as the one shown in FIG. 156, still cameras, etc. The display apparatus is used as a monitor 144 attached to a camera body 1561. The camera body 1561 is equipped with a switch 1554 as well as a shutter 1563.

The EL display panel of the present invention is adoptable for a 3D(three-dimensional) display apparatus. FIGS. 605 and 606 are schematic diagrams of the 3D display apparatus of the present invention. As shown in FIG. 605, the two EL display panels (EL display arrays) 30a and 30b are placed face-to-face. A picture electrode 15a of a display panel 30a and a picture electrode 15b of a display panel 30b are placed at face-to-face positions. The distance between the two EL display panels is kept by an isolation post 6161. The isolation post 6161 is placed around the display area 144, and is ring-shaped. It is made of an inorganic material such as glass. The isolation post 6161 may be formed or configured by a pressure membrane technique, a coating technique and a printing technique. The array substrate 30 may also be formed by digging the display area 144 by using an etching technique or a polishing technique.

The isolation post 6161 is 1 mm to 8 mm thick. In particular, it is desirable to render the isolation post 6161 3 mm to 7 mm thick. The isolation post 6161 is attached to the panels 30a and 30b by a sealing resin 6162. In a space 6163, the desiccant is placed, formed or configured as required.

The picture electrode 15a of the display panel 30a and the picture electrode 15b of the display panel 30b display different images or the same image. The images are monitored from the direction A. Therefore, the EL display panel 30a needs to be transparent. It is because there is a need to monitor the image displayed on the picture electrode 15b of the display panel 30b via the picture electrode 15a. The display panel 30b may be either transparent or reflective.

A display image 144a of the display panel 30a is displayed more brightly (at a higher luminance) than a display image 144b of the display panel 30b. A luminance difference is generated between the display image 144a and the display image 144b so that the image viewed from the side A looks three-dimensional. The luminance difference should be 10 to 80 percent. In particular, it should be 20 to 60 percent.

FIG. 606 is a schematic diagram of the image display state of the two display panels 30. The controller circuit (IC) 760 controls a source driver circuit (IC) 14a of the display panel 30a and a source driver circuit (IC) 14b of the display panel 30b and thereby controls the image so as to implement the 3D display with the display images 144a and 144b.

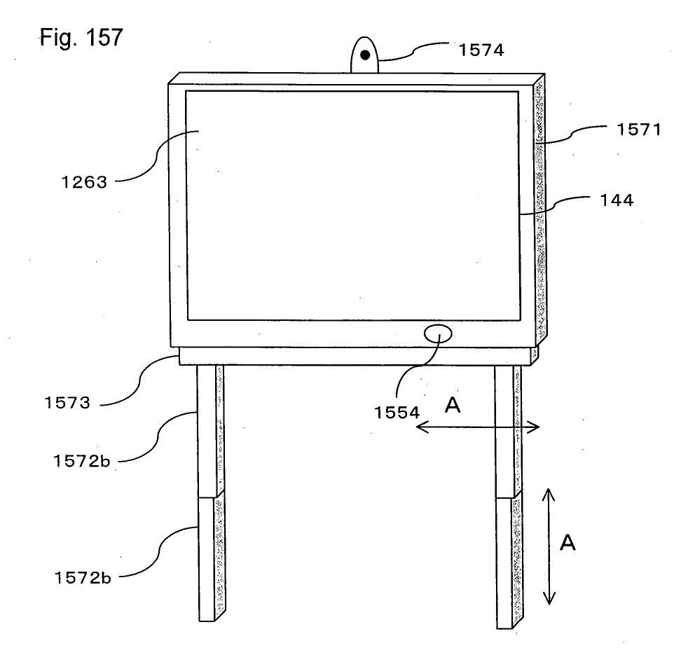

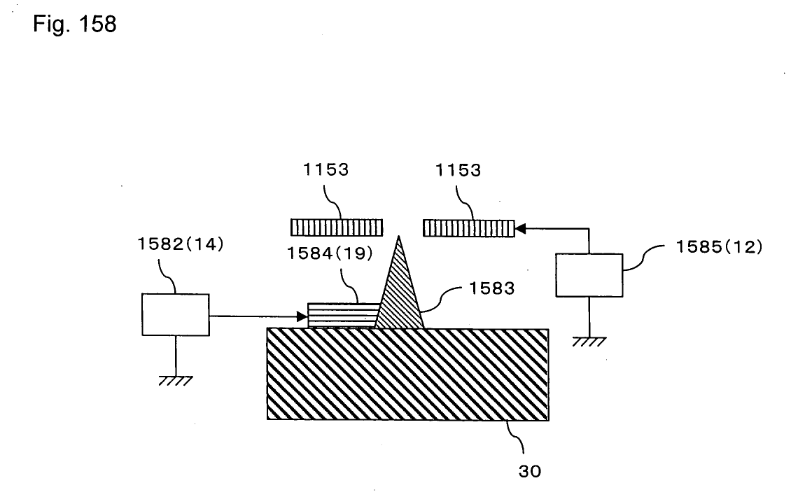

The display panel described above has a relatively small display area. However, with a display area of 30 inches or larger, the display screen 144 tends to flex. To deal with this situation, the present invention puts the display panel in a frame 1571 and attaches a fitting 1574 so that the frame 1571 can be suspended as shown in FIG. 157. The display panel is mounted on a wall or the like using the fitting 1574.

A large screen size increases the weight of the display panel. As a measure against this situation, the display panel is mounted on a stand 1573, to which a plurality of legs 1572 are attached to support the weight of the display panel.

The legs 1572 can be moved from side to side as indicated by A. Also, the legs 1572 can be contracted as indicated by B. Thus, the display apparatus can be installed even in a small space.

A television set in FIG. 157 has a surface of its screen covered with a protective film (or a protective plate). One purpose of the protective film is to prevent the surface of the display panel from breakage by protecting from being hit by something. An AIR coat is formed on the surface of the protective film. Also, the surface is embossed to reduce glare caused by extraneous light on the display panel.

A space is formed between the protective film and display panel by spraying beads or the like. Fine projections are formed on the rear face of the protective film to maintain the space between the protective film and display panel. The space prevents impacts from being transmitted from the protective film to the display panel.

Also, it is useful to inject an optical coupling agent into the space between the protective film and display panel. The optical coupling agent may be a liquid such as alcohol or ethylene glycol, a gel such as acrylic resin, or a solid resin such as epoxy. The optical coupling agent can prevent interfacial reflection and function as a cushioning material.

The protective film may be, for example, a polycarbonate film (plate), polypropylene film (plate), acrylic film (plate), polyester film (plate), PVA film (plate), etc. Besides, it goes without saying that an engineering resin film (ABS, etc.) may be used. Also, it may be made of an inorganic material such as tempered glass. Instead of using a protective film, the surface of the display panel may be coated with epoxy resin, phenolic resin, and acrylic resin 0.5 mm to 2.0 mm thick (both inclusive) to produce a similar effect. Also, it is useful to emboss surfaces of the resin.

It is also useful to coat surfaces of the protective film or coating material with fluorine. This will make it easy to wipe dirt from the surfaces with a detergent. Also, the protective film may be made thick and used for a front light as well as for the screen surface.

The above embodiment uses the display panel of the present invention as the display apparatus. However, the present invention is not limited thereto. FIG. 573 shows the embodiment for using it as an information generating apparatus. As described in FIG. 14, it is possible, by means of the signal (an ST signal in particular) inputted to the gate driver circuit 12, to generate the non-lit-up area 192 and lit-up area 193 as described in FIGS. 54, 439 and 469. The lit-up area 193 is the area in which the EL element 15 of the relevant pixel 16 is emitting light. To be more specific, it is the area in which the on voltage is applied to the gate signal line 17b and the transistor 11d is in the on state in the pixel configuration of FIG. 1. The non-lit-up area 192 is the area in which no current is flowing in the EL element 15 of the relevant pixel 16. To be more specific, it is the area in which the off voltage is applied to the gate signal line 17b and the transistor 11d is in the off state in the pixel configuration of FIG. 1.

If a signal of the white raster display is applied to the display area 144 from the source driver circuit (IC) 14, it is possible, by controlling the gate driver 12b, to generate the lit-up areas 193 and non-lit-up areas 192 like stripes (because it is lighting-controlled and non-lighting-controlled by pixel line) in the display area 144. As shown in FIG. 573, a bar-code display can be implemented by controlling the gate driver 12b.

An ST1 terminal of the gate driver circuit 12a has a start pulse applied thereto once a frame. An ST2 terminal of the gate driver circuit 12b has a start pulse applied thereto correspondingly to the bar-code display. A difference from a bar-code of ordinary printed matter is that each bar-code display position in the display area 144 moves in synchronization with a horizontal scanning signal.

Therefore, as shown in FIG. 572, it is possible to place or form a photosensor 5721 capable of detecting the lit-up state of one pixel line in the display area 144 of an EL display panel 5723 so as to detect the display state of the bar-code in a state of having the photosensor 5721 fixed at the rate of 1/(frame number-pixel line number per second). The data detected by the photosensor 5721 is converted to an electrical signal by a decoder (a bar-code decoder) 5722 to be decoded and become information.

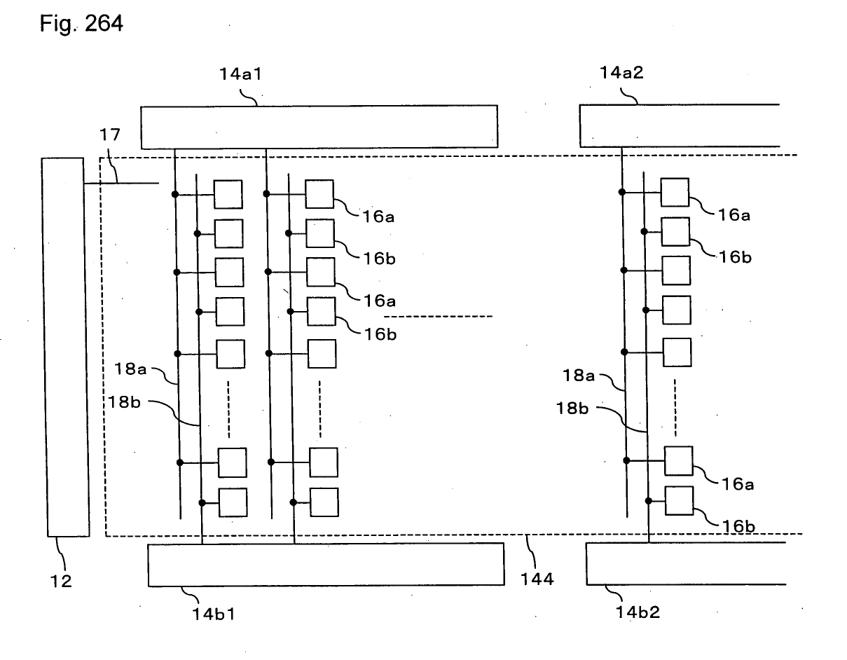

If the display panel becomes large, the parasitic capacitance of the source signal line 18 also becomes large. Therefore, the current program is apt to become difficult. As for this problem, the source driver circuits 14 are placed at the top and bottom of the screen 144 as shown in FIG. 264. The number of the source signal lines 18 also becomes twice (18a and 18b). It is possible, by having the above configuration, to have the program current applied to the odd-numbered pixel lines by the source driver circuit (IC) 14a and to the even-numbered pixel lines by the source driver circuit (IC) 14b.

Therefore, conventionally, one pixel line is selected and the period for applying the program current is 1H period. In the configuration of FIG. 264, however, it is possible to simultaneously select two pixel lines and apply the program current. Therefore, it is possible to apply the program current Iw to each pixel line for 2H periods. For that reason, it is possible to secure a sufficient writing period of the program current and implement a good current program even if the panel size becomes large. It goes without saying that the above is also applicable to the voltage program method.

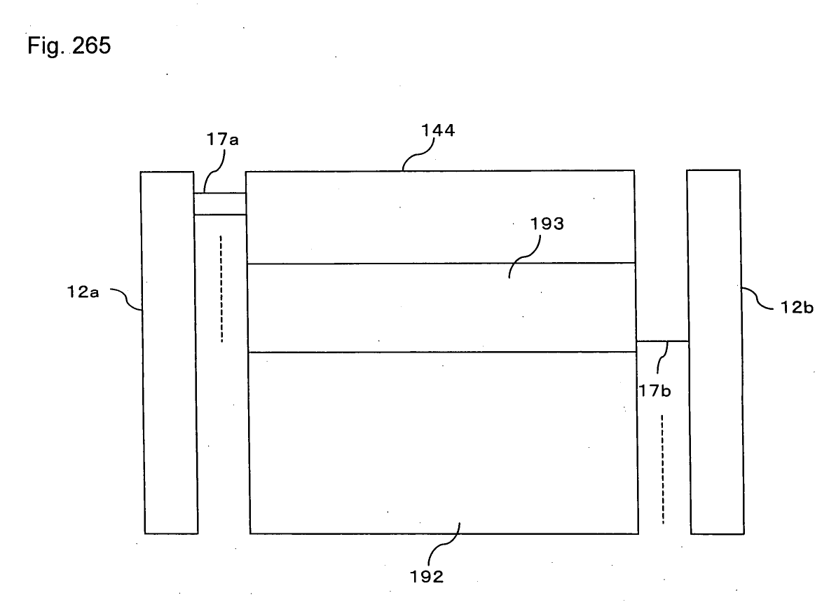

It is possible, even if driven as in FIG. 264, to apply the duty ratio control of the present invention. In the case of FIG. 265 for instance, the gate driver circuit 12a on the pixel writing side selects two gate signal lines 17a and scans selected positions two by two. The gate driver circuit 12b on the EL selection side selects one pixel line sequentially (that is, sequentially selects one gate signal line 17b).

Therefore, the current program side selects multiple gate signal lines 17a and implements the current program, and the duty ratio control side controls one gate signal line 17b and implements the duty ratio control as in the conventional cases. It goes without saying that the above is also applicable to the reference current ratio control.

The screen may be divided. In the case of dividing it into two, there are the configuration for dividing it into the top and bottom at the center of the screen and the configuration for dividing it by one pixel line (or multiple pixel lines) as in FIGS. 264 and 559. In FIG. 559, the source driver circuit (IC) 14a has the source signal line 18a connected thereto. The source signal line 18a has the pixels of the even-numbered pixel lines connected thereto. The source driver circuit (IC) 14b has the source signal line 18b connected thereto. The source signal line 18b has the pixels of the odd-numbered pixel lines connected thereto.

As a characteristic of the current driving, the program current can be added just by shorting multiple output terminals. For instance, in the case where the first terminal outputs 10 μA and the second terminal outputs 20 μA, the output shorting the first and second terminals is 10+20=30 μA. It is not possible to short multiple terminals in the case of the voltage driving. For instance, in the case where the first terminal outputs 1V and the second terminal outputs 2V, the output shorting the first and second terminals is put in a short state and is destroyed.

As described above, shorting the output terminals causes no problem in the case of the current driving (current control method). It is possible, by applying this characteristic effect, to increase the number of gradations easily. FIG. 560 shows that embodiment. Hereunder, the embodiment of the present invention will be described by referring to FIG. 560.

FIG. 560 is a block diagram of the source driver circuit of the present invention. In FIG. 560, reference numeral 431c denotes a transistor group 1 of the transistor group 431c indicates that a unit transistor 153 is comprised of one piece. And 1 outputs the program current equivalent to one gradation, where the lowest-order bit is relevant to it. 2 shown in the transistor group 431c of FIG. 560 indicates that the unit transistor 153 is comprised of two pieces. And it outputs the program current equivalent to two gradations, where the second bit is relevant to it. Similarly, 4 indicates that the unit transistor 153 is comprised of four pieces. And it outputs the program current equivalent to four gradations, where the third bit is relevant to it. Similarly, 8 indicates that the unit transistor 153 is comprised of eight pieces. And it outputs the program current equivalent to eight gradations, where the fifth bit is relevant to it. 16 indicates that the unit transistor 153 is comprised of sixteen pieces. And it outputs the program current equivalent to sixteen gradations, where the fifth bit is relevant to it.

Similarly, 32 indicates that the unit transistor 153 is comprised of thirty-two pieces. And it outputs the program current equivalent to thirty-two gradations, where the sixth bit is relevant to it. Therefore, it is possible for the transistor group 431c to output the program current of 64 gradations.

The source driver circuit (IC) of the present invention has one transistor group 431c formed (configured) for each output terminal 155. As a characteristic of the current driving, the program current can be added just by shorting multiple output terminals. Therefore, it is easy to increase the number of gradations by combining the outputs from the multiple output terminals. For instance, it is possible, if one output is 64 gradations, to implement 64+64−1=127 gradations by combining two outputs. −1 is given because of the 0^{th} gradation. To facilitate the description, the following description will be given on condition that the source driver circuit (IC) of the present invention is basically 64 gradations and 128 outputs.

Therefore, the source driver circuit (IC) 14 of 128 outputs and 64 gradations can be used as a driver IC of 64 outputs and 127 gradations. FIG. 560 is that embodiment. A switch (SW) 5601 is placed between the two outputs. When using the driver IC 14 as 64 gradations, the switch 5601 is used in the open state. When using it as 127 gradations, the switch 5601 is used in the closed state. The switch is an analog switch. The switch 5601 is controllable to be open and closed by a logic signal of the control terminal of the driver IC 14.

If switches 5602a and 5602b are used in the closed state in FIG. 560, they can be used as a 64-gradation driver of 128 outputs. The switch 5601 is closed. And if the switch 5602a is closed and the switch 5602b is opened, it is possible to output the program current of 127 gradations from the terminal 155a. Therefore, it is possible to apply the program current to the pixel 16 (not shown) connected to the source signal line 18a. In this case, it is not possible to apply the program current to the source signal line 18b. However, it is possible, by alternately controlling closing and opening of the switches 5602a and 5602b, to alternately output the program current to the adjacent output terminals 155a and 155b. They are alternately switched and synchronized with scanning of the gate signal lines 17. Therefore, it is possible to apply the program current to the source signal lines 18a and 18b. It is bit input.

Therefore, they are used as in FIG. 562 when there is no need to switch between the source signal lines 18a and 18b (when using them as the source driver circuits (IC) of 127 gradations from the beginning). In this case, the switches 5602 are not necessary.

Each transistor group 431c is 6-bit input. Therefore, 6 bits are inputted to a transistor group 431c1 according to the number of gradations up to the 64^{th} gradation or 63^{rd} gradation, and all the 6 input bits to a transistor group 431c2 are 0. From the 64^{th} gradation or 65^{th} gradation, 6 bits are inputted to a transistor group 431c1 according to the number of gradations, and all the 6 input bits to a transistor group 431c2 are 1. (The program current equivalent to 63 gradations is added). The transistor group 431c2 collectively operates 63 unit transistors 153.

In FIG. 560, the current output of 127 gradations is performed by combining two current output stages (431c and so on). However, it is 1 gradation less than 128 gradations. This is because there are only 63 unit transistors 153 comprising the transistor group 431c. Therefore, there are only 126 unit transistors 153 even if two transistor groups 431c are combined. Thus, at gradation 0, it is possible to only represent up to 127 gradations even if the number of the operating unit transistors 153 is 0.

FIG. 561 shows the configuration for solving this problem. The transistor group 431c2 has a selected unit transistor 5611 equivalent to 1 unit added (formed or placed) thereto. In the case of using it as 128 gradations (the case of using it with 64 gradations or more), the selected unit transistor 5611 is operated. The transistor group 431c2 is comprised of 64 unit transistors 153. The transistor group 431c2 collectively operates the 64 unit transistors 153. In the case of below 128 gradations, all the unit transistors 153 of the transistor group 431c2 are in a non-operating state. In the case of 128 gradations or more, the unit transistors 153 of the transistor group 431c2 are operated. Therefore, it is also possible to use the transistor group 431c2 comprised of 64 unit transistors 153 from the beginning. The unit transistors 153 of the transistor group 431c1 are changed correspondingly to the bits according to the number of gradations.

The source driver circuit (IC) 14 has a standard transistor group 431, configured as a standard cell, comprised of 63 unit transistors 153 representing 64 gradations or 63 unit transistors 153 and one selected unit transistor 5611. It is possible, by laying out a plurality of the standard cells, to easily form (configure) the source driver circuit (IC) of arbitrary gradations. It goes without saying that the standard cell is not limited to 63 unit transistors 153 but may also be comprised of 127 or 255 unit transistors 153.

The above embodiments are the cases of 64 gradations and 128 gradations. The present invention is not limited thereto. In the case of 256 gradations for instance, it may be configured as in FIG. 563. The switch 5601 is placed between the two outputs. When using the driver IC 14 as 64 gradations, the switch 5601 is used in the open state. When using the driver IC 14 as 256 gradations, the switch 5601 is used in the closed state. The switch 5601 is controllable to be opened and closed by the logic signal of the control terminal of the driver IC 14.

The above embodiments describe that reference numeral 14 denotes the source driver circuit (IC). However, it is not limited thereto. For instance, the source driver circuit (IC) 14 may be the one formed by the low-temperature polysilicon technique, high-temperature polysilicon technique and CGS technique. To be more specific, the source driver circuit (IC) 14 may be the one formed directly on the substrate 30. The above is also applicable to the following embodiments.

Referring now mainly to FIG. 564, a description will be given as to the EL display apparatus comprising the first source driver circuit (IC) 14a connected to one end of the source signal line 18 and the second source driver circuit (IC) 14b connected to the other end of the source signal line 18, wherein the first source driver circuit (IC) 14a and the second source driver circuit (IC) 14b output the currents corresponding to the gradations.

FIGS. 560 to 563 show the configurations for connecting one source driver circuit (IC) 14 correspondingly to each source signal line 18. However, the present invention is not limited thereto. For instance, it is possible, as shown in FIG. 564, to connect the source driver circuit (IC) 14 of the present invention to both ends of one source signal line.

Each source signal line 18 has the source driver circuit (IC) 14a connected to one end thereof and the source driver circuit (IC) 14b connected to the other end thereof. The transistor group 431c1 of the source driver circuit (IC) 14a is comprised of 63 unit transistors 153. The transistor group 431c2 of the source driver circuit (IC) 14b is comprised of 63 unit transistors 153 and one selected unit transistor 5611.

The transistor group 431c2 may be comprised of 64 unit transistors 153. The transistor group 431c2 has only two modes in which all the 64 unit transistors 153 are either operating or non-operating. Therefore, it may also be formed by a transistor 64 times as large as the unit transistor 153.

If configured as above, the transistor group 431c1 has the corresponding unit transistors 153 operating according to the input data up to 64 gradations, and the transistor group 431c2 collectively operates with 64 gradations or more.

To be more specific, in the configurations of FIG. 564, the source driver circuit (IC) 14a capable of representing 64 gradations is connected to one end of the source signal line 18, and the transistor group 431c2 comprised of the number of the unit transistors 153 comprising the transistor group 431c1 of the source driver circuit (IC) 14a +1 transistor 153 is connected to the other end of the source signal line. The source driver circuit (IC) 14b may be comprised of the transistors 64 times the unit transistor 153.

To be more specific, it is easy to implement 128 gradations by using the source driver circuit (IC) 14a comprised of 63 unit transistors 153 and the source driver circuit (IC) 14b comprised of 64 transistors 153. In the case of using 2 source driver circuit (IC) 14a comprised of 63 transistors 153, 127 gradations can be represented. As for the image display, there is no difference between 127 gradations and 128 gradations from a practical viewpoint. Therefore, it is also possible to use 2 source driver circuits (IC) 14a comprised of 63 unit transistors 153.

In the case of below 64 gradations, all the unit transistors 153 of the transistor group 431c2 are in the non-operating state. In the case of 64 gradations or more, the unit transistors 153 of the transistor group 431c2 are operated. Therefore, it is also possible to use the transistor group 431c2 comprised of 64 unit transistors 153 from the beginning. The unit transistors 153 of the transistor group 431c1 are changed correspondingly to the bits according to the number of gradations. Therefore, it is possible to implement multiple-tone display by using a plurality of the source driver circuits (IC) 14 of 64 gradations.

In the case of 128 gradations or more, the transistor group 431c of the source driver circuit (IC) 14 should be comprised of 64 or more unit transistors 153. According to the configuration of FIG. 564, it is possible to implement the multiple-tone display easily by using the source driver circuit (IC) 14 of the small number of gradations. This is an application of a characteristic effect of the current driving method that the output current can be added just by shorting multiple output terminals.

The embodiment of FIG. 564 is the embodiment in which the output terminals of two source driver circuits (IC) 14 are connected to one source signal line 18. However, the present invention is not limited thereto. It goes without saying that the output terminals of three or more source driver circuits (IC) 14 may be connected to one source signal line 18. It also goes without saying that the technical idea of the switch 5601 of FIG. 560 may be introduced to the configuration of FIG. 564.

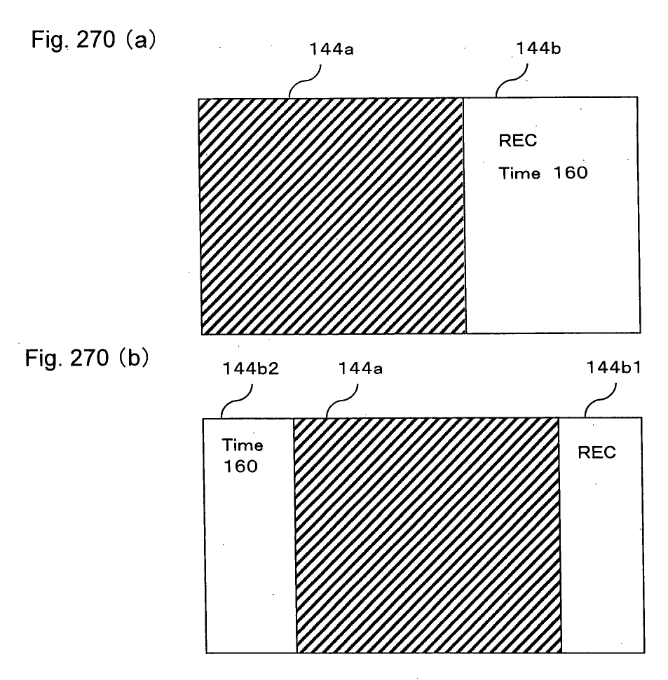

When the display panel displays the screen of 4:3 on the wide-type screen 144 of 16:9, the screen 144a of 4:3 is displayed at the end of the screen of 16:9 as shown in FIG. 270(a). OSD(On Screen Display) is performed on the remaining screen 144b. It is desirable to synthesize the display 144b of OSD and the display of the screen 144a as the video signal in advance.

The screen 144a of 4:3 is displayed at the center of the screen of 16:9 as shown in FIG. 270(b). OSD (On Screen Display) is performed on the remaining screens 144b1 and 144b2. It is desirable to synthesize the display 144b of OSD and the display of the screen 144a as the video signal in advance.

As shown in FIG. 327, the controller circuit (IC) 760 controls a power-supply module 3272 and the source driver circuit (IC) 14 placed or configured in a panel module. The configuration and operation of the power-supply module 3272 are described in FIGS. 119, 120, 121, 122, 123, 124, 125, 251, 262, 263, 268 and 280, and so a description thereof will be omitted. The configuration and operation of the panel were also previously described, and so a description thereof will be omitted.

The power-supply module 3272 has the power supplied from a lithium battery 3271. The power-supply module 3272 generates the voltages Vgh, Vgl, Vdd and Vss (hereafter, these voltages are referred to as panel voltages). The timing for generating the panel voltages is controlled by the on-off signal of the controller circuit (IC) 760. The power for the controller circuit (IC) 760 is supplied from a main body circuit. Therefore, the device having the display apparatus of the present invention operates on having a power supply voltage supplied to the controller circuit (IC) 760 first. After the controller circuit (IC) 760 starts, the power-supply module 3272 generates the panel voltages according to the on-off signal of the controller circuit (IC) 760. The generated voltages are applied as the voltages Vdd and Vss of the gate driver circuit 12, the source driver circuit (IC) 14 and the panel. It is possible, by configuring it as above, to reduce the number of wirings between the main body circuit and the panel module.

The device of the present invention has at least the controller circuit (IC) 760 and the battery 3271 in the main body circuit. Therefore, the panel module and the main body circuit have five (or more) wirings consisting of two wirings of the differential signals for transmitting the video signals of the RGB, two wirings of Vcc and GND for supplying the voltage of the panel module 3272 and one signal line for controlling on and off of the power-supply module 3272.

FIG. 367 is a deformation example of FIG. 327. The controller circuit (IC) 760 has a PLL circuit 3611a which synchronizes the differential signals. The RGB and RGBD which is control data (D) are transmitted as the differential signals by a pair of signal lines (refer to FIGS. 80 to 82, FIG. 292 and FIGS. 327 to 331). Synchronization signals of RGBD signals are also transmitted likewise as CLK differential signals by a pair of signal lines. The St signals of the differential signals are transmitted by a pair of signal lines in order to indicate a start (initial position of a pair) to the RGBD signals. The St signals do not have to be the differential signals but may be transmitted as the logic signals of CMOS and TTL.

A power supply circuit 3271 has the power applied as the voltage Vcc from the battery (not shown) by the two lines of GND, and also has the on-off signal of the power supply circuit 3271 applied from the controller circuit (IC) 760.

FIG. 367 has the configuration for transmitting the RGBD as a pair of differential signals. However, the present invention is not limited thereto. It is also possible, as shown in FIGS. 361, to render red video data (RDATA) as a pair of differential signals, green video data (GDATA) as a pair of differential signals and blue video data (BDATA) as a pair of differential signals. The pre-charge bit is added to the differential signals of each of the RGB. To be more specific, RDATA of red has a PrR bit of whether or not to pre-charge the relevant data of red added thereto (RDATA 8 bits+PrR 1 bit). GDATA of green has a PrG bit of whether or not to pre-charge the relevant data of red added thereto (GDATA 8 bits+PrG 1 bit). BDATA of blue has a PrB bit of whether or not to pre-charge the relevant data of blue added thereto (BDATA 8 bits+PrB 1 bit).

As shown in FIG. 371, DATA (RDATA, GDATA and so on) and CLK synchronized therewith have the same frequency. To be more specific, the DATA contents are identified at a rising edge and a falling edge of CLK. Such a relation between DATA and CLK is kept so as to render the frequency steady and reduce unnecessary radiation.

FIG. 357 describes the relation with the St signals in addition to FIG. 371. The CLK, ST and RGB or (RGBD) (refer to FIGS. 80 to 82, FIG. 292 and FIGS. 327 to 331) of the video signal are sent (transmitted) at an amplitude of a voltage Diff centering on OV (GND). The voltage Diff as the amplitude is set, rendered variable or adjusted by the circuit configuration of FIGS. 368 to 370.

As shown in FIG. 357, the RGB as the video signals and CLK synchronized therewith have the same frequency. To be more specific, the DATA contents are identified at a rising edge and a falling edge of CLK. Such a relation between DATA and CLK is kept so as to render the frequency steady and reduce unnecessary radiation. The St signal is twice wider than CLK, and is detected at the rising edge or the falling edge of CLK. CLK is phase-controlled by a PLL circuit 3611. The differential signals are sent as above so as to perform transmission and reception.

The transmission of the differential signals or signals of the present invention is characterized by having a pre-charge determination bit in addition to the video signals of the RGB. This is described in FIGS. 76 to 78. Therefore, as shown in FIGS. 359, the R, G and B data has the pre-charge bit (Pr).

FIG. 359(a) shows the case of the video data of 10 bits. It has the pre-charge bit (Pr) in addition to 10 bits (D9 to D0) of the video data. It also has a D/C bit, as the most significant bit, for identifying whether a command or the video data. When the D/C bit is 1, it indicates that the bit in the following data area is a command. The command is normally transmitted in a horizontal blanking period or a vertical blanking period. The command was described in FIGS. 329 and 331, and so a description thereof will be omitted. When the D/C bit is 0, it indicates the video data, and the video data (8 bits or 10 bits) and the determination bit (Pr) of the pre-charge voltage (program voltage) are transmitted as the data.

FIG. 359(b) shows the case of the video data of 8 bits (D7 to D0). Similar to FIG. 359(a), it has the pre-charge bit (Pr) in addition to the video data. It is also the same as FIG. 359(a) in having a D/C bit, as the most significant bit, for identifying whether a command or the video data. When the D/C bit is 0, it indicates the video data, and the video data (8 bits or 10 bits) and the determination bit (Pr) of the pre-charge voltage (program voltage) are transmitted as the data.

The data of FIGS. 359 is transmitted in synchronization with CLK of FIG. 357. And the ST signal is transmitted in a cycle of RGB video data corresponding to one pixel or RGB video data corresponding to one pixel+control data D.

FIG. 364 shows the embodiment for transmitting the ST signal by making R pixel Pr bit+R video data, G pixel Pr bit+G video data, B pixel Pr bit+B video data, and control data as one set.

FIG. 365 shows the embodiment for transmitting the ST signal per control data of 11 bits. The control data is comprised of the 2-bit address data (A1, A2), pre-charge bit (Pr) and 8-bit data (D7 to D0). When A (1:0) which is the address data (A1, A2) is 0, it indicates that the data (7:0) is the control data (described in FIGS. 329 and 331, and so a description thereof will be omitted). When A (1:0) is 1, it indicates that the data (7:0) is the video data of R. When A (1:0) is 2, it indicates that the data (7:0) is the video data of G. When A (1:0) is 3, it indicates that the data (7:0) is the video data of B. It goes without saying that the Pr bit may be transmitted as a part of the control data or the video data.

FIGS. 366 are similar to FIG. 364. FIG. 366 (b) has the configuration for transmitting the video data (including the pre-charge bit) RGB, such as R, G, B, R, G, B, R, G, B . . . . FIG. 366(a) has the configuration for transmitting the control data D as required. Therefore, in the case where the image data is just transmitted in an image transmission period as in FIG. 366(b), the control data is inserted as in FIG. 366(a) so as to transmit the image data until the horizontal blanking period. However, transmission efficiency in FIG. 366(a) is high in that there is no need to secure the period of the control data as in FIG. 364 and the horizontal blanking period is effectively used.

FIG. 362 shows the method of bit-expanding and transmitting the video data (the video data is transmitted by pixel in FIG. 364). As indicated by a data start position A in FIG. 362, the data is transmitted, such as the pre-charge bit of R PrR, pre-charge bit of G PrG, pre-charge bit of B PrB, 7^{th} bit (most significant bit) of the video data of R, 7^{th} bit (most significant bit) of the video data of G, 7^{th} bit (most significant bit) of the video data of B, 8^{th} bit of the video data of R, 6^{th} bit of the video data of G, 6^{th} bit of the video data of B, 5^{th} bit of the video data of R, 5^{th} bit of the video data of G, 5^{th} bit of the video data of B, . . . 0^{th} bit (least significant bit) of the video data of R, 0^{th} bit (least significant bit) of the video data of G, 0^{th} bit (least significant bit) of the video data of B, and then the pre-charge bit of R of the next pixel PrR, pre-charge bit of G PrG, pre-charge bit of B PrB, 7^{th} bit (most significant bit) of the video data of PR, 7^{th} bit (most significant bit) of the video data of G, 7^{th} bit (most significant bit) of the video data of B, and so on.

FIG. 363 shows the method of sequentially transmitting the video data, control data D and image data. It transmits the pre-charge bits Pr of the RGB, image data and control data. First, it transmits Pr of R and 8-bit image data (R (7:0)), Pr of G and 8-bit image data (G (7:0) ), Pr of B and 8-bit image data (B (7:0)) and control data D(9:0) as one cycle. Next, it transmits Pr of R of the next pixel and 8-bit image data (R (7:0)), Pr of G and 8-bit image data (G (7:0)), Pr of B and 8-bit image data (B (7:0)) and control data D(9:0) as one cycle.

As described above, the present invention has a variety of embodiments. A common point is that the Pr data is transmitted. It goes without saying that the Pr data may be included as the bits in a control command.

The above embodiment is the embodiment for transmitting the bits for controlling the pre-charge voltage to the source driver circuit (IC) 14 by means of the differential signal (not limited to the differential signal). However, the present invention is not limited thereto. In FIGS. 381 to 422, the embodiments of the overcurrent driving were described. In FIGS. 389, 391, 392(b) and 402, the size of the overcurrent and the signal or symbol for controlling the application period for the overcurrent were described.

FIG. 423 shows an interface specification or format for transmitting the size of the overcurrent and the signal or symbol for controlling the application period for the overcurrent described in FIGS. 389, 391, 392(b) and 402. The matters other than the transmission of the overcurrent data or control signal are described in FIGS. 80 to 82, 296, 319, 320, 327 to 337, 357 and 359 to 372, and so a description thereof will be omitted. The matters described in these drawings are applied to FIGS. 423 to 426 and FIGS. 477 to 484. It goes without saying that the matters described in FIGS. 423 to 426 are also applicable to the other embodiments of the present invention.

In FIG. 423, overcurrent control symbols K are transmitted. Basically, the overcurrent control symbols K (Kr for a red pixel, Kg for a green pixel and Kb for a blue pixel) are in FIG. 362. K is described in FIGS. 391 and 392, and so a description thereof will be omitted. However, the symbols or data to be transmitted are not limited to K. For instance, it may be T of FIGS. 402. To be more specific, the technical idea of the present invention is to transmit the data, symbol or control signal related to the overcurrent driving by means of the differential signal. The above is also applicable to FIGS. 424 to 426.

FIG. 424 basically shows the configuration in which the overcurrent control symbols K (Kr for a red pixel, Kg for a green pixel and Kb for a blue pixel) are added to the transmission method, transmission format or transmission system of FIG. 361. K is described in FIGS. 391 and 392, and so a description thereof will be omitted. However, the symbols or data to be transmitted is not limited to K. For instance, it may be T of FIGS. 402. To be more specific, the technical idea of the present invention is to transmit the data, symbol or control signal related to the overcurrent driving by means of the differential signal. In FIG. 424, the data on the overcurrent is transmitted by a twisted pair differential signal. As indicated by DDATA, the control signal of the pre-charge voltage is also transmitted.

FIG. 425 shows the embodiment for transmitting the CLK, R data and overcurrent control signal of R (R+Kr), G data and overcurrent control signal of G (G+Kg), B data and overcurrent control signal of B (B+Kb) and the control data (D) on the gate driver circuit by means of the twisted pair differential signal. It is the embodiment for transmitting a right-shift start pulse (STHR) of the source driver circuit (IC) 14, a left-shift start pulse (STHL) of the source driver circuit (IC) 14, a flip vertical control signal (RL) of the gate driver circuit (IC) 12 and a load signal (LD) of the video data by means of a TTL or CMOS level signal.

FIG. 426 shows the embodiment for transmitting the CLK, video data, control data and overcurrent control signal (RGBD+) by means of the twisted pair differential signal. It is the embodiment for transmitting a right-shift start pulse (STHR) of the source driver circuit (IC) 14, a left-shift start pulse (STHL) of the source driver circuit (IC) 14, a flip vertical control signal (RL) of the gate driver circuit (IC) 12 and a load signal (LD) of the video data by means of a TTL or CMOS level signal.

FIGS. 432 also show the transmission format of the display apparatus of the present invention. FIG. 432 (a) shows the configuration in which the pre-charge bit P is added to each of the data of 8 bits of the RGB. A determination bit Pr for determining whether or not to pre-charge the R pixel is transmitted followed by a first pixel data of R R1(7:0), a determination bit Pg for determining whether or not to pre-charge the G pixel is transmitted followed by a first pixel data of G G1(7:0), and a determination bit Pb for determining whether or not to pre-charge the B pixel is transmitted followed by a first pixel data of B B1(7:0). Hereafter, similarly, a determination bit Pr for determining whether or not to pre-charge the R pixel is transmitted followed by a second pixel data of R R2(7:0), a determination bit Pg for determining whether or not to pre-charge the G pixel is transmitted followed by a second pixel data of G G2(7:0), and a determination bit Pb for determining whether or not to pre-charge the B pixel is transmitted followed by a second pixel data of B B2(7:0).

To be more specific, they are transmitted, such as Pr, R1(7:0), Pg, G1(7:0), Pb, B1(7:0), Pr, R2 (7:0), Pg, G2(7:0), Pb, B2(7:0), Pr, R3(7:0), Pg, G3(7:0), Pb, B3(7:0), Pr, R4(7:0), Pg, G4 (7:0), Pb, B4(7:0), Pr, R5(7:0), Pg, G5(7:0), Pb, B5(7:0), and so on.

FIG. 432(b) has the configuration in which the pre-charge bit P is multiplexed in each of the data of 8 bits of the RGB. The determination bit Pr for determining whether or not to pre-charge the R pixel is multiplexed in the R1(7:0) bit. An MSB of the R1 data is used as the pre-charge bit. It is because the MSB is not used for the image data (it is 0) for applying the pre-charge voltage in the case of the low gradation. Therefore, in the case of performing the pre-charge, the MSB bit is set at 1 so as to indicate that the relevant video data is pre-charged. The pre-charge bit is extracted in the source driver IC so as to implement the pre-charge operation.

Hereafter, similarly, the determination bit Pg for determining whether or not to pre-charge the G pixel is multiplexed in the G1(7:0) bit. The determination bit Pb for determining whether or not to pre-charge the B pixel is multiplexed in the (7:0) bit. To be more specific, they are transmitted, such as R1(7:0), G1 (7:0), B1(7:0), R2(7:0), G2(7:0), B2(7:0), R3(7:0), G3(7:0), B3(7:0), R4(7:0), G4(7:0), B4(7:0), R5(7:0), G5(7:0), B5(7:0), Rn(7:0), Gn(7:0), and Bn(7:0).

The video data of R, G and B is not limited to being transmitted by independent twisted pair lines respectively. FIGS. 433 show that embodiment. FIGS. 433(a), (b), (c) and (d) show the twisted pair lines of the differential signals respectively. The twisted pair line (a) transmits the high-order 8 bits of the R data (R (9:2)). The twisted pair line (b) transmits the high-order 8 bits of the G data (G (9:2)). The twisted pair line (c) transmits the high-order 8 bits of the B data (B (9:2)) The twisted pair line (d) transmits command data CM, low-order 2 bits of the R data (R (1:0)), low-order 2 bits of the G data (G (1:0)) and low-order 2 bits of the B data (B (1:0)).

The embodiments of FIGS. 367 and 361 are the embodiments in which the PLL circuit 3611a is placed or configured on the side for sending the differential signals. However, the present invention is not limited thereto. It is also possible, as shown in FIGS. 360, to place or configure a PLL circuit 3611b on the receiving side (the source driver circuit (IC) 14 in FIGS. 360) as well. It is possible to place the PLL circuits 3611 on the sending side and receiving side and set the number of cycles of DATA as the differential signals (the number of sets) on the sending side and receiving side so as to transmit high-speed differential signal data by smaller number of signal lines.

In FIGS. 360, the PLL circuit 3611b uses the CLK indicating the cycle (start position) of DATA to perform oscillations of the number of data in one cycle of differential signal DATA so as to decode DATA as the differential signal and convert it to a parallel signal.

According to the present invention, it is justified so that the impedance is changeable or can adjust on the sending side and receiving side of the differential signal. The larger the amplitude of the differential signal is, the longer the transmission distance can be. However, transmission power becomes larger if the amplitude is large. In the case of outputting the differential signal by the constant current, it is possible to increase the amplitude by increasing the impedance on the receiving side of the differential signal. Therefore, it becomes possible to receive the differential signal even if the transmitted current is small. However, it becomes weak against noise.

It is desirable, in view of the above, to be capable of setting or adjusting the amplitude and impedance of the differential signal from the distance for transmitting the differential signal and the power required for the transmission. FIGS. 368 to 370 show the embodiments.

FIG. 368 shows the circuit configuration on the receiving side of the differential signal. It has an impedance setting circuit 3682 in the source driver circuit (IC) 14. The impedance setting circuit 3682 is comprised of Rs (R1, R2, R3 and R4 in FIG. 368) having different resistance values (impedance values) and switches S (S1, S2, S3 and S4 in FIG. 368) for selecting the Rs. One or more switches S are turned on and resistances R are selected by the signal or voltage applied to a signal input terminal RSEL of the source driver circuit (IC) 14. The input terminals 2883 of the differential signals have the selected resistances R connected thereto.

According to the present invention, the constant current is passed through a differential signal wiring. Therefore, it is possible, with the values of the resistances R, to change an amplitude value of the differential signal generated between the terminal 2883a and the terminal 2883b. To be more specific, it is possible to adjust the amplitude of the differential signals according to the transmission distance.

FIG. 369 shows another embodiment. A built-in resistance Rx is variably configured. The previously described electronic regulator 501 is shown as an example of the variable configuration. In addition, it is also adjustable by trimming.

FIG. 370 shows a configuration example on the sending side. It has the configuration in which a variable voltage source or a fixed voltage is inputted between a terminal 2884c and a terminal 2884d. It has the configuration in which the current output of the constant current circuit inside the controller circuit (IC) 760 is changeable by the voltage inputted to the terminals 2884c and 2884d. It is possible, by this operation, to change the current of the differential signal outputted from the terminals 2884a and 2884b.

In FIG. 368, the resistances R in the source driver circuit (IC) 14 are selected (switched) by the RSEL signal. However, the present invention is not limited thereto. It is also possible, for instance, to change the connection with an IC mask as in FIGS. 372.

FIGS. 372 show the embodiment in which the resistances R1, R2 and R3 are formed or configured in the source driver IC 14 in advance, and a final mask (for aluminum wiring formation) is changed on manufacturing the source driver IC 14 so as to change the resistances connected to the terminals 2883. To be more specific, the aluminum wiring connecting the resistances R to the terminals 2883 is changed to switch the impedances connected to the terminals 2883 (2883a and 2883b).

FIG. 372(a) shows the configuration in which parallel impedances comprised of the resistances R1 and R3 are connected to the terminals 2883. FIG. 372(b) shows the configuration in which parallel impedances comprised of the resistances R3 are connected to the terminals 2883.

It goes without saying that the above is also applicable to the embodiment of FIG. 370. Multiple constant current sources are formed or configured in the controller circuit (IC) 760 in advance, and the final mask (for aluminum wiring formation) is changed on manufacturing the controller circuit (IC) 760 so as to change the constant current outputted from the terminals 2884.

As shown in FIG. 328, the differential signal is outputted in synchronization with H and L of a signal A (determination signal) of the main body circuit. When the signal A is L, the program voltages (VR, VG, VB) are outputted. When the signal A is H, the program currents (IR, IG, IB) are outputted. Output operations of the program voltages and program currents are described in FIGS. 127 to 143, 293 and 338, and so a description thereof will be omitted.

The program currents (IR, IG, IB) and program voltages (VR, VG, VB) as the video signals and data signals DM and DS are transmitted. To be more specific, the differential signal has four phases of R video signal, G video signal, B video signal and D data signal multiplexed (VR, IR, VG, IG, VB, IB, DM, DS, VR, IR, . . . ) In a video blanking period, the DM and DS signals are successively transmitted as shown in FIG. 330. 8-bit or 10-bit data of DM which is the data is the command. 8-bit or 10-bit data of DS which is the data is the control data. FIG. 329 is an example of DM. DM represents the horizontal synchronizing signal (HD) and vertical synchronizing signal (VD). DM=1 is the HD signal by way of example. DM=1 is the VD signal. DM=3 is a UD signal for inverting the top and bottom of the image on the screen. DM=4 is an RL signal for inverting the right and left of the image on the screen 144.

Similarly, DM=5 indicates pre-charge time (PR-time) of R, DM=6 indicates pre-charge time (PG-time) of G, and DM=7 indicates pre-charge time (PB-time) of B. DM=8 indicates the reference current (reference I-R) of R, DM=9 indicates the reference current (reference I-G) of R, and DM=10 indicates the reference current (reference I-B) of R. Similarly, DM=10 also indicates output timing of the start pulse of the gate driver circuit 12. As described above, DM is the data for performing specification as the command.

It goes without saying that, as for the pre-charge time, it may be applied from the controller circuit (IC) 760 to the source driver IC 14 by a waveform signal of TTL or CMOS logic. For instance, it is controlled or configured so that the pre-charge voltage (pre-charge current) is applied to the source signal line 18 in an H-level period of the waveform signal of the logic, and no pre-charge voltage (pre-charge current) is outputted to the source signal line 18 in an L-level period of the waveform signal of the logic. It goes without saying that the pre-charge time may be controlled (rendered variable) according to the lighting rate. When the lighting rate is low, it means that there are many pixels of the low gradations. Therefore, Therefore, the pre-charge time is extended. Inversely, when the lighting rate is high, it means that there are many pixels of the high gradations. In this case, the shortage of writing of the program current does not occur or is not conspicuous (not recognized). Therefore, the pre-charge time may be short.

FIGS. 331 show examples of the contents of the DS signal. When DM=9, it is the control signal of the gate driver circuit 12. As for 8 bits of DS, placement of each bit is decided as in ex. 1. bit0 is an enable signal (ENBL1) of the gate driver circuit 12a. bit1 is a clock signal (CLK1) of the gate driver circuit 12a. bit2 is a start signal (ST1) of the gate driver circuit 12a. bit4 is an enable signal (ENBL2) of the gate driver circuit 12b. bit5 is a clock signal (CLK2) of the gate driver circuit 12b. bit6 is a start signal (ST2) of the gate driver circuit 12b. As shown in ex. 3, when DM=8, the DS signal indicates the size of the reference current of R as the data. As above, DS is the data specified by DM.

The above embodiments described that the signals are transmitted as the differential signals. It goes without saying that they may be transmitted in RSDS as a standard format of the differential signals, as a matter of course. FIG. 505 shows an example of transmitting the pre-charge signals and video signals in the RSDS signal format. Even the RSDS format has novelty in the procedure and format of the transmitted data according to the present invention. Further, it goes without saying that the following matters to be described are also applicable to the present invention described hereinbefore. For instance, they can be applicable to FIGS. 360 to 366, 389 to 394, 432, 433 and so on.

According to the following embodiment, the current pre-charge is 3 bits and there are six kinds of current pre-charge period. However, they are not limited thereto. There may also be over or below six kinds. The pre-charge signals (RP0 to 2, GP0 to 2, BP0 to 2) are not limited to the current pre-charge but may also be the voltage pre-charge.

According to the following embodiment, it is described that the data is transferred as the differential signals (RSDS, LVDS, mini LVDS and so on) by using the twisted pair lines. However, it is not limited thereto. It may also be transferred by the CMOS-level or TTL-level signals which are logic signals. In this case, it goes without saying that there is no need to use the twisted pair lines. The present invention is characterized by serially transmitting the data and converting it to parallel signals in a serial to parallel conversion portion 3681. Therefore, it goes without saying that transfer (transmission) of the data is not limited to the differential signals. It goes without saying that they may be not only the current signals but also voltage signals. It goes without saying that they may be transferred not only by wire signals but also by radio signals (optical signals such as radio waves and infrared light). The above is also applicable to the other embodiments of the present invention.

In FIGS. 505 and 506, a clock latches the data at the rising edge and falling edge. Therefore, the frequency of the clock is ½ of a data transfer rate. The R data uses the twisted pair lines of two differentials. The Gdata and Bdata also use the twisted pair lines of two differentials. FIG. 505 is a drawing showing data transfer time, and FIG. 506 is a drawing describing command transfer time.

In the embodiment of FIG. 505, there are 3 bits for specifying the current pre-charge such as that of the overcurrent. The video data is 8 bits for each of the RGB. As for the R data, 3 pieces of pre-charge specification data (RP0, RP1, RP2) and C/D data (C/D=H) are transmitted in a period B. The C/D data is a switching signal between the command and data. When C/D=L, it indicates that the signal transmitted by the twisted pair line (transmission line) is the command signal (control signal). When C/D=H, it indicates that the signal transmitted by the twisted pair line (transmission line) is the data signal (video signal, pre-charge specification signal). Therefore, it is in the state of transferring the data in FIG. 505, and so it is C/D=H.

As the pre-charge specification signal is 3 bits, it can be represented in eight different ways. FIG. 514 shows an example of the specification signal in eight different ways. In the table in FIG. 514, IPC indicates the current pre-charge, and VPC indicates the voltage pre-charge. The current pre-charge IPC is constantly at the L level when the specification signal IS=0 and 7. To be more specific, the voltage pre-charge period is 0, and so the voltage pre-charge is not implemented as a result.

When the specification signal IS=0, the voltage pre-charge VPC is also constantly at the L level. To be more specific, the voltage pre-charge period is 0, and so the voltage pre-charge is not implemented as a result. Therefore, when the specification signal IS=0, neither the current pre-charge nor the voltage pre-charge is implemented. Consequently, the normal current program driving is implemented when the specification signal IS =0 (refer to the description of the period B in FIG. 130).

When the specification signal IS=7, the voltage pre-charge VPC is implemented although the current pre-charge IPC is constantly at the L level. To be more specific, only the voltage pre-charge is implemented. Consequently, the normal current program driving is implemented after the voltage pre-charge is implemented (refer to the description of the embodiment implemented by the periods A and B in 1H in FIG. 129).

When the specification signal IS=1, a current pre-charge pulse 1 is selected and implemented as the current pre-charge IPC after the voltage pre-charge VPC is implemented. Length of each current pre-charge pulse is set on command transfer in FIG. 506 (refer to FIG. 507 as well). The overcurrent driving is implemented in a current pre-charge pulse 1 for a set-up period. To be more specific, a large writing current is applied to the source signal line 18. FIGS. 410(a1) (a2) and (a3) fall under this embodiment. To be more specific, the pre-charge voltage V0 is applied to the source signal line 18, and the potential is reset to the voltage V0 (initialization voltage: constant voltage or fixed voltage) in the source signal line 18 (FIG. 410(a1)) Next or simultaneously with the pre-charge voltage, the overcurrent voltage Id is applied to the source signal line 18 (FIG. 410(a2)). Refer to FIG. 484 and the description thereof.

It goes without saying that, as in FIG. 410(a2), the pre-charge current Id may be applied simultaneously with the pre-charge voltage V0 or the driving may be performed so that the pre-charge voltage application period does not overlap the pre-charge current application period (the pre-charge current is applied after completing (finishing) the pre-charge voltage application period). It goes without saying that the driving may be performed as in FIG. 410(b1) to 410(b3) and FIG. 410(c1) to 410(c3).

It goes without saying that the driving methods of FIGS. 411 to 413, and the driving methods of FIGS. 414 to 422, etc. can be combined with the driving methods of FIGS. 505, 506, 507, 514, 508 to 513, etc. In the case of changing (specifying) the voltage pre-charge period and the voltage pre-charge voltage value, the number of bits for the specification or change is required. To be more specific, it is necessary to expand the number of the specification signal IS of FIG. 514 on condition that the pre-charge bits are 4 bits or more rather than 3 bits.

It goes without saying that the embodiments of FIGS. 127 to 142, and 331 to 336 can be combined with the driving methods of FIGS. 505, 506, 507, 514, 508 to 513, etc. Also as for the rest, it goes without saying that the source driver circuit (constitution), the display panel or display apparatus, the driving method, the inspection method, etc. according to the present invention can be mutually combined with the embodiments of FIGS. 411 to 413, 414 to 422, 505, 506, 507, 514 508 to 513, 127 to 142 and 331 to 336, etc.

When the specification signal IS=2, after the voltage pre-charge VPC is implemented, a current pre-charge pulse 2 is selected as the current pre-charge IPC and the overcurrent driving is implemented. To be more specific, the overcurrent Id is applied to the source signal line 18 in the period of a current pre-charge pulse 2.

Same as above, when the specification signal IS=3, after the voltage pre-charge VPC is implemented, a current pre-charge pulse 3 is selected as the current pre-charge IPC. When the specification signal IS=4, after the voltage pre-charge VPC is implemented, a current pre-charge pulse 4 is selected as the current pre-charge IPC. When the specification signal IS=5, after the voltage pre-charge VPC is implemented, a current pre-charge pulse 5 is selected as the current pre-charge IPC. When the specification signal IS=6, after the voltage pre-charge VPC is implemented, a current pre-charge pulse 6 is selected as the current pre-charge IPC.

According to the present invention, it is described that the larger the number of*of the current pre-charge pulse*is, the longer the period for applying the overcurrent Id (current of the current pre-charge) to the source signal line 18 becomes. According to the present invention, it is described that the current pre-charge period is changed. However, it is not limited thereto. It is also possible to change (specify) the size of the current pre-charge current with the specification signal IS. It goes without saying that the voltage pre-charge period or the applied voltage of the voltage pre-charge may be changed (specified).

As with the R data, the G data transmits 3 pieces of pre-charge specification data (GP0, GP1 and Gp2) and GSIG7 data (refer to FIG. 508 and the description thereof) in the period B. The B data transmits 3 pieces of pre-charge specification data (BP0, BP1 and Bp2) and GSIG8 data (refer to FIG. 508 and the description thereof) in the period B.

As described above, the signal for specifying the current pre-charge and the other signals such as C/D are transferred in the period B. The transfer is performed from the controller circuit (IC) 760 to the source driver circuit (IC) 14.

The R data as the video signal is transferred in the period C of the R data. To be more specific, RD0 [0] to RD0 [7] are transferred. The subscript in brackets [ ] of RD0 [*] indicates a bit position of the video data. To be more specific, RD0 [0] indicates the least significant bit of the 0^{th} of the R data, and RD0 [7] indicates the most significant bit of the 0^{th} of the R data. The * of RD*[ ] indicates the order of the video data. For instance, RD0 [ ] indicates the data of the 0^{th} pixel of R, and RD7 [ ] indicates the data of the 7^{th} pixel of R. Similarly, RD18 [ ] indicates the data of the 18^{th} pixel of R. The above is also applicable to the video G data and video B data.

The G data as the video signal is transferred in the period C of the G data. To be more specific, GD0 [ ] to GD0 [7] are transferred. The B data as the video signal is transferred in the period C of the B data. To be more specific, BD0 [0] to BD0 [7] are transferred.

Period B+period C is the period A. The data on one pixel of each of the RGB is transferred in the period A. To be more specific, data, which specify whether or not to pre-charge each of the 8-bit video data on each of the RGB, each of the video data, and in the case of pre-charging it, what pre-charge to be implemented, are transferred. In addition, the control data on the gate driver circuit 12 is transferred. The above is also applicable to the video G data and video B data. To be more specific, 6-bit serial data is transferred in parallel by 7-twisted pair signal lines in the period A.

In the embodiments hereinbefore, it has been described that 6-bit serial data is transferred in parallel by 7-twisted pair signal lines in the period A. However, the present invention is not limited thereto. 7-bit serial data may be transferred in parallel by 6-twisted pair signal lines in the period A. Needless to say, other methods may also be used.

The control data on the gate driver circuit 12 is also transferred as the serial data (gate data of FIG. 505). This explains FIG. 292. The data transferred as the serial data from the controller circuit (IC) 760 to the source driver circuit (IC) 14 is converted to parallel data in the source driver circuit (IC) 14 and applied to the gate driver circuit 12.

In FIG. 505, 6 pieces of data (GSIG1 to GSIG6) are transferred by one twisted pair signal line in the period A. The control data on the gate driver circuit 12 is placed on the G data and B data in addition to the pair lines of the gate data. To be more specific, 8 control signals in total are transferred in the period A by adding two pieces of GSIG7 of the G data transferred by the twisted pair and GSIG8 of the B data transferred by the twisted pair.

As shown in FIG. 508, the gate data applied as a serial signal to the source driver circuit (IC) 14 is converted to the parallel signal by the serial to parallel conversion portion 3681 of the source driver circuit (IC) 14. 8 bits are transferred as the control data on the gate driver circuit 12. FIG. 508 is a drawing limited only to the control of the gate driver circuit 12 (serial to parallel development of the video signal of the source driver circuit is omitted). Refer to FIG. 292 and the description thereof. The serial to parallel conversion portion 3681 has a GOE terminal. If an L-level signal is applied to the GOE terminal, all OGSIG terminals are put in a high-impedance state. To be more specific, it is a 3-state terminal. When put in the high-impedance state, the OGSIG terminals are put in a state of being separated from the source driver circuit (IC) 14. Thus, it is possible to connect signals from outside to the OGSIG terminals. To be more specific, they are put in a state of using no serial signal such as the gate data, and so it is possible to directly connect the control signals of the gate driver circuit 12 of the parallel signals.

The configuration of FIG. 508 is the one showing the details of or similar to the configurations of FIGS. 282 to 284, 288 to 292, 316, 319, 320, 327, 347, 358, 365, 367, 373 and 374. Accordingly, it goes without saying that the contents or configurations described in FIGS. 282 to 284, 288 to 292, 316, 319, 320, 327, 347, 358, 365, 367, 373, and 374 can be combined with those in FIG. 508.

Specification of the 8 control signals is arbitrary. According to the present invention, however, GSIG1 is a start pulse (ST1) signal of the gate driver circuit 12a, GSIG2 is a clock (CLK1) signal of the gate driver circuit 12a, and GSIG3 is an enable (OEV1:refer to FIG. 40) signal of the gate driver circuit 12a. GSIG1 is outputted from the OGSIG1 terminal and applied to the gate driver circuit 12a. GSIG2 is outputted from the OGSIG2 terminal and applied to the gate driver circuit 12a. Similarly, GSIG3 is outputted from the OGSIG3 terminal and applied to the gate driver circuit 12a.

GSIG4 is a start pulse (ST2) signal of the gate driver circuit 12b, GSIG5 is a clock (CLK2) signal of the gate driver circuit 12b, and GSIG6 is an enable (OEV2:refer to FIG. 40) signal of the gate driver circuit 12b. GSIG4 is outputted from the OGSIG4 terminal and applied to the gate driver circuit 12b. GSIG5 is outputted from the OGSIG5 terminal and applied to the gate driver circuit 12b. Similarly, GSIG6 is outputted from the OGSIG6 terminal and applied to the gate driver circuit 12b.

As described above, the present invention is characterized by comprising common control signals among multiple gate driver circuits 12. It is also characterized by being capable of controlling the OGSIG terminals in the high-impedance state and connecting the other control signals to the OGSIG terminals.

GSIG7 is a common signal between the gate driver circuit 12a and the gate driver circuit 12b. To be more precise, GSIG7 is the UD(up-down) signal for switching the display direction of the display screen vertically. GSIG7 is outputted from the OGSIG7L terminal and applied to the gate driver circuit 12a. At the same time, GSIG7 is outputted from the OGSIG7R terminal and applied to the gate driver circuit 12b.

GSIG8 is also a common signal between the gate driver circuit 12a and the gate driver circuit 12b. To be more precise, GSIG8 is a common enable signal (OEV3) between the gate driver circuits 12a and 12b. GSIG8 is outputted from the OGSIG8L terminal and applied to the gate driver circuit 12a. At the same time, GSIG8 is outputted from the OGSIG8R terminal and applied to the gate driver circuit 12b.

FIG. 509 is a schematic diagram of the control signals GSIG of the gate driver circuit 12. The control signals of the gate driver circuit 12 are DY[1], DZ[1] and the gate data. 8 bits of the control data of the gate driver circuit 12 are determined by 3 clocks (the clocks latch them at the rising edge and the falling edge). Therefore, when the 3 clocks of the period Al are finished, the data on GSIG1 to GSIG8 is outputted from the OGSIG1 to OGSIG8 terminals. This output is held during a period A2 following the period A1. During the period A2, when the 3 clocks of the period A2 are finished, the data on GSIG1 to GSIG8 is outputted from the OGSIG1 to OGSIG8 terminals. This output is held during a period A3 following the period A2.

When a GOE signal of FIG. 508 is at the H level, the data on GSIG1 to GSIG8 is outputted as OGSIG1 to OGSIG8 from the terminals. When the GOE signal is at the L level, the OGSIG1 to OGSIG8 terminals are in the high-impedance state (described as Hi-Z in FIG. 509).

The gate data was described as the control signal of the gate driver circuit 12. However, it is not limited thereto. For instance, it may also be the control data of the source driver circuit (IC) 14 or temperature control data of the panel. The video data of the period A is not limited to the video data. It may also be a luminance (Y) signal, a color difference (C) signal or a control data signal of the source driver circuit.

The present invention is characterized by applying the serial data to the source driver circuit (IC) 14 for generating the video signal, developing the serial data applied to the source driver circuit (IC) 14 into the parallel data, and controlling the gate driver circuit 12 with the output signal of the source driver circuit (IC) 14. It is possible, by having the above configuration, to cut down on the number of signal lines connected between the display panel and the controller circuit (IC) 760 so as to reduce connection flexible area and lower the cost.

As for the period A, the number of data equivalent to the number of pixels of 1 pixel line is generated in 1 horizontal scanning period (1H). For instance, if the number of pixels of 1 pixel line is 320 dots, there are 320 periods A. The data is transferred as in FIG. 505.

FIG. 506 shows the command transfer time. To be more precise, the command transfer time is the blanking period of the 1H period. The setup data (commands) such as a reference current set value of the source driver circuit and a pre-charge voltage set value are transferred in the blanking period.

The commands are transferred as six twisted pairs. They are DX[0], DX[1], DY[0], DY[1], DZ[0] and DZ[1]. As the control over the gate driver circuit 12 is also necessary in the blanking period, the gate data is transmitted by the twisted pair lines. The GSIG7 and GSIG8 signals are also transferred.

When transferring the command, the C/D data is transferred at the H level. The serial to parallel conversion portion 3681 of the source driver circuit (IC) 14 determines the logic level of the C/D data, and judges whether it is in a data transfer state or a command transfer state. To be more specific, when the C/D data=H, it is processed on condition that the video data is transferred. And when the C/D data=L, it is processed on condition that the command data is transferred. The C/D data position is detected by the horizontal synchronizing signal and a pixel number counter.

In FIG. 506, 3-bit address data (ADDR) is transferred in the period B. Set-up command data (CMD) is transferred in the period C. The command data consists of CMD1 to CMD5, and each command (CMD) is 6 bits. As for the commands CMD1 to CMD5, DX[1] is the most significant bit (MSB) while DZ[0] is the least significant bit. To be more specific, the subscripts in the brackets [ ] of CMD1 [*], CMD2 [*], CMD3 [*], CMD4 [*] and CMD5 [*] indicate the bit positions.

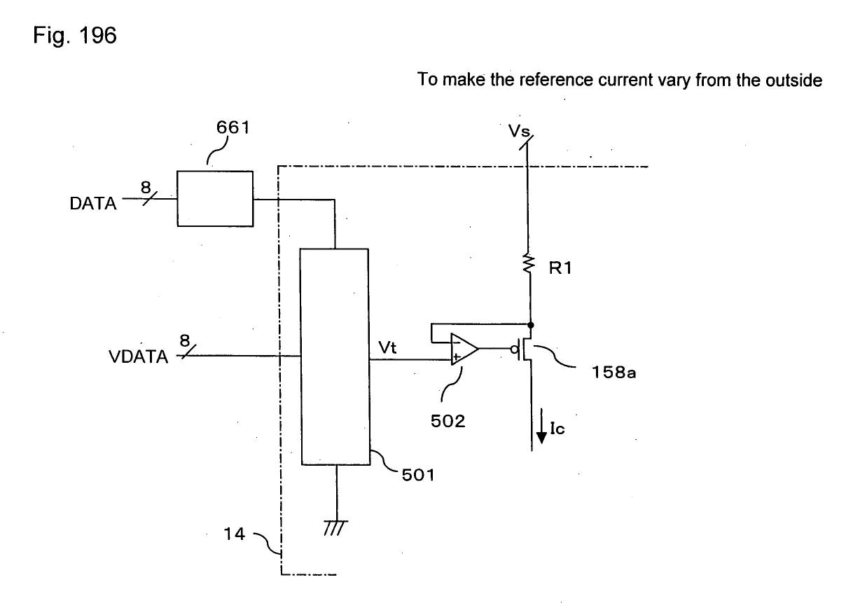

In FIG. 506, 3-bit address data is transferred in the period B. The address data (ADDR) indicates the contents of the command (CMD) data as shown in the table of FIG. 507. When ADDR [2] to [0] is ‘000’ for instance, the commands CMD5 to CMD1 set the reference current (Ic) (DATA or IDATA). Since the reference current Ic and the data for setting reference current have been described referring to FIGS. 50, 60, 61, 64 to 66, 131, 140, 141, 145, 188, 196 to 200, 346, 377 to 379, 397 and so on, description thereof is omitted. If CMD0 is at theH level, it is in the mode for being pre-charge-controlled by the external terminal of the source driver circuit (IC) 14.

When ADDR [2] to [0] is 10011 to 1010, the commands CMD5 to CMD1 set the length of the current pre-charge pulse. The length of the pulse is set by the circuit configuration of FIG. 513. CMD1 is the length setting of the current pre-charge pulse 1. Similarly, CMD2 is the length setting of the current pre-charge pulse 2, CMD3 is the length setting of the current pre-charge pulse 3, CMD4 is the length setting of the current pre-charge pulse 4, and CMD5 is the length setting of the current pre-charge pulse 5.

The voltage pre-charge voltage value is set by 6 bits of the command CMD2 when ADDR [2] to [0] is ‘010’ as shown in FIG. 507. Since it has been described referring to FIGS. 16, 75 to 79, 127 to 142, 410 to 413 and so on, the description thereof is omitted.

The length of each current pre-charge pulse is set by counting until it matches with the set-up 6-bit counter value. Clock counting of the counter is performed by 3 bits of pre-charge pulse generation clock setting (PpS) of CMD4 when ADDR [2] to [0] is 7^{th} bit ‘010.’ If the pre-charge pulse generation clock setting is rendered larger, the CLK is divided by a divider circuit 5132 to change count speed of the counter 4682. The larger the pre-charge pulse generation clock setting (PpS) is rendered, the larger the divider circuit 5132 becomes. Therefore, the count speed of the counter 4682 slows down so that the period for applying the current pre-charge pulse consequently becomes longer.

As shown in FIG. 513, a pre-charge pulse generating portion 5131 is mainly configured by the counter 4682 and a pulse generating portion 5133. As for the counter circuit 4682 of the pre-charge pulse generating portion 5131, the clock having divided the CLK is applied to the divider circuit 5132 by a PpS signal. The operation of the counter 4682 is controlled by the load signal (LD). The load signal (LD) is basically the horizontal synchronizing signal.

The pulse generating portion 5133 generates six kinds of current pre-charge pulse period TIp according to the specification signal IS as shown in FIG. 514. It also generates a voltage pre-charge pulse period VIp according to the setup. The periods Tip and TVp are changed by the set value of the divider circuit 5132. Therefore, the source driver circuit (IC) 14 of the present invention is able to cope with change in the subject panel size.

As shown in FIG. 513, the specification signal IS (IS is 3 bits) is extracted according to ADDR and CMD (refer to FIG. 506). The signal IS is latched in a latching circuit (holding circuit) 5134 and held for the period of 1H. The signal IS corresponding to each pixel is inputted to a selector circuit 5135 placed or formed in each source signal line 18. The inputted signal IS is decoded in the selector circuit 5135, and one current pre-charge pulse period is selected out of the six current pre-charge pulse periods TIp (no pulse period is selected when IS=0 or 7).) When IS=7, the voltage pre-charge pulse period is selected, where only the voltage pre-charge is implemented. When IS=1 to 6, the voltage pre-charge is implemented and then the current pre-charge is implemented.

FIG. 510 is a timing chart of the voltage pre-charge and the current pre-charge. The voltage pre-charge period is started at the falling edge of an LD pulse which is the horizontal synchronizing signal. When the voltage pre-charge pulse is at the H level, the pre-charge voltage is outputted from the source driver circuit (IC) 14. FIG. 510 indicates the voltage pre-charge period by C. The current pre-charge period is started at the falling edge of the LD pulse which is the horizontal synchronizing signal. When at the current pre-charge pulse 1, the C+A period is the period for current-pre-charging. When at the current pre-charge pulse 2, the C+B period is the period for current-pre-charging which is longer than the period of the current pre-charge pulse 1. Hereunder, a current pre-charge pulse 3 has the period longer than that of the current pre-charge pulse 2, and a current pre-charge pulse 4 has the period longer than that of the current pre-charge pulse 3. The above relation is set or configured up to a current pre-charge pulse 6 by the circuit configuration of FIG. 513 and the set values of FIG. 507.

FIGS. 511 and 512 are block diagrams of a current pre-charge output stage configured or formed in the source driver circuit (IC) 14. FIGS. 511 and 512 have the configurations which are the same as, similar to or deformed from or having functions described concretely in or added to the previously described configurations of FIGS. 381 to 394, FIGS. 398 to 399, FIGS. 402 to 421, FIGS. 432 to 435, FIGS. 457 to 462 and FIGS. 470 to 484. Therefore, it is possible to combine them with one another. As there are many overlapping points, the differences will be mainly described.

FIG. 511 shows one output stage of an 8-bit video current signal. Video data D[0] to D[7] are outputted from the terminal 155 by closing a switch D*a (* denotes 0 to 7 indicating the bit position). As for the switch D*a, the relevant switch closes according to the video data. A switch D*b (* denotes 0 to 7 indicating the bit position) is closed during the current pre-charge period. The maximum current (overcurrent Id) out of the unit current output stage 431c is outputted from the terminal 155 by closing the switch D*b.

The pre-charge voltage Vp is outputted from the terminal 155 by closing the switch. 151a. The pre-charge current Id and the program current Iw are outputted from the terminal 155 by closing the switch 151b. The switches 151a and 151b are controlled by an inverter 142 so as not to be simultaneously closed.

Logic data is applied to the inverter 142 by a pre-charge period determining portion 5112. To be more specific, the pre-charge period determining portion 5112 controls the inverter 142 by a length set value of the current pre-charge pulse of FIG. 507.

FIG. 512 shows the configuration in which the switches D*a and D*b are replaced by an OR gate. The maximum current (overcurrent Id) out of the unit current output stage 431c is outputted from the terminal 155 by the output signal from the pre-charge period determining portion 5112.

The display panel according to the example of the present invention may be used in combination with the three-side free configuration. The three-side free configuration is useful especially when pixels are built using amorphous silicon technology. Also, in the case of panels formed using amorphous silicon technology, since it is difficult to control variations in the characteristics of transistor elements during production processes, it is preferable to use the N-pulse driving, reset driving, reference current ratio control, duty ratio control, dummy pixel driving (FIG. 271 etc.), or the like according to the present invention. That is, the transistors 11 according to the present invention are not limited to those produced by polysilicon technology, and they may be produced by amorphous silicon technology.

Thus, the transistors 11 or the like composing the pixels 16 in the display panels according to the present invention may be formed by amorphous silicon technology. Needless to say the gate driver circuits 12 and source driver circuits (IC) 14 may also be formed or constructed by amorphous silicon technology. It goes without saying that the transistors may be organic transistors. The driving circuit of a speaker 2512 of FIG. 251 is not limited to the one by the polysilicon technique but may also be the one by amorphous silicon.

The N-fold pulse driving (FIGS., 13, 16, 19, 20, 22, 24, 30, 271, 274, etc.) and the like according to the present invention are more effective for display panels which contain transistors 11 formed by low-temperature polysilicon technology than display panels which contain transistors 11 formed by amorphous silicon technology. This is because adjacent transistors, when formed by amorphous silicon technology, have almost equal characteristics. Thus, driving currents for individual transistors are close to a target value even if the transistors are driven by current obtained by addition (the N-fold pulse driving in FIGS. 22, 24, 30, 271, and 274 in particular, are effective also for pixel configurations containing amorphous silicon transistors).

It is possible, irrespective of whether regarding a part or all of the following, to mutually combine the pixel configuration, display panel (display apparatus), control method or technical idea thereof, the driving method, control method or technical idea of the display panel or display apparatus, the driving circuits or controller IC (circuit) such as the source driver circuit (IC) and gate driver IC (circuit), or control circuits thereof and the method of adjustment or control thereof (including the gate driver circuit) or technical idea thereof described in this specification. It goes without saying that they may be mutually applied, configured, formed or applied as a method.

It goes without saying that the technical idea of the inspection apparatus, inspection method or adjustment method of the present invention is applicable to the display panel, display apparatus or method of the present invention. It goes without saying that these configurations, methods or apparatuses are applicable not only to the display panel of the low-temperature polysilicon but also to the display panel of amorphous silicon and the display panel configured by the CGS technique.

The technical category of the present invention also includes the display panel or display apparatus in which a part of the substrate 30 (such as the display area 144) is configured or formed by an amorphous silicon technique and other parts (such as the driver circuits 12 and 14) are formed or configured by the low-temperature polysilicon technique and the CGS technique.

The duty cycle control driving, reference current control, N-fold pulse driving, source driver circuit (IC), gate driver configuration and other drive methods and drive circuits according to the present invention described herein are not limited to drive methods and drive circuits for organic EL display panels. Needless to say they are also applicable to other displays such as field emission displays (FEDs), SEDs (displays developed by Cannon and Toshiba) as shown in FIG. 159.

In an FED shown in FIG. 158, an electron emission protuberance 1583 (which corresponds to the pixel electrode 35 in FIG. 3) which emits electrons in a matrix is formed on a board 30. A pixel contains a holding circuit 1584 (which corresponds to the capacitor in FIG. 1) which holds image data received from a video signal circuit 1582 (which corresponds to the source driver circuit (IC) 14 in FIG. 1). Also, control electrodes 1581 are placed in front of the electron emission protuberance 1583. Voltage signals are applied to the control electrodes 1581 by an on/off control circuit 1585 (which corresponds to the gate driver circuit 12 in FIG. 1).

The pixel configuration in FIG. 158 can perform N-fold pulse driving, duty cycle control driving, etc. if a peripheral circuit shown in FIG. 174 is added. An image data signal is applied to the source signal line 18 from the video signal circuit 1582. A pixel 16 selection signal is applied to a selection signal line 2173 by an on/off control circuit 1585a, and consequently pixels 16 are selected one after another and image data is written into them. Also, an on/off signal is applied to an on/off signal line 1742 by an on/off control circuit 1585b, and consequently the FED of pixels is subjected to on/off control (duty cycle control). It is possible to mutually combine the technical ideas irrespective of whether regarding a part or all thereof.

It goes without saying that the configuration of FIG. 158 can have the various configurations or methods, constitutions, systems, device configurations and display methods described in the specification of the present invention applied thereto, such as the duty ratio control, reference current control, pre-charge-control, lighting rate control, AI control, peak current suppression control, panel wire routing, configuration or driving method of the source driver circuit (IC) 14, circuit configuration or control method of the gate driver circuits, trimming method, program voltage+program current driving method and inspection method. It goes without saying that the above is also applicable to the other embodiments of the present invention.

It is possible to mutually combine the technical ideas irrespective of whether regarding a part or all thereof. It goes without saying that the above is particularly applicable to the self-luminous devices or apparatuses, such as FED and SED.

The output stage of the source driver circuit (IC) 14 (such as the unit transistor group 431c) of the present invention is described mainly as the one for performing the current output (outputting the program current). However, it is not limited thereto. It is also possible to have the program voltage outputted by the output stage (FIG. 2 is relevant as the pixel configuration). A voltage output stage is exemplified by the one for converting to the voltage with the operational amplifier and outputting it to correspond to the reference current Ic.

The voltage output stage is exemplified by the one for converting the output current Id to the voltage with the operational amplifier and outputting it. It is also exemplified by the one for converting the video data to the voltage data, implementing a gamma process to the voltage data and outputting it from the output terminal 155. As described above, the output of the source driver circuit (IC) 14 of the present invention is not limited to the program current but may also be the program voltage.

In FIGS. 77, 78 and 75, it was described that the pre-charge signal applied to the source signal line 18 is the voltage. However, it is not limited thereto. It may also be the current. It is also possible to mutually combine the technical ideas irrespective of whether regarding a part or all thereof.

It was described that the present invention changes, adjusts, varies or renders variable the reference current, duty ratio, pre-charge voltage (synonymous with or similar to the program voltage), gate signal line voltages (Vgh, Vgl) and gamma curve by means of the image (video) data, lighting rate, current passing through the anode (cathode) terminal and panel temperature. However, it is not limited thereto. For instance, it goes without saying that the reference current, duty ratio, pre-charge voltage (synonymous with or similar to the program voltage), output current of the source signal line 18, gate signal line voltages (Vgh, Vgl) and gamma curve may be changed, adjusted, varied, rendered variable or controlled by predicting or estimating the change ratio or change in the image (video) data, lighting rate, current passing through the anode (cathode) terminal and panel temperature. It also goes without saying that the frame rate may be changed or varied. It is also possible to mutually combine the technical ideas irrespective of whether regarding a part or all thereof.

According to the present invention, a change is made to the first lighting rate (may be the anode current of the anode terminal) or lighting rate range (may be the anode current range of the anode terminal) as the first FRC, lighting rate, current passing through the anode (cathode) terminal, reference current, duty ratio or panel temperature or combinations thereof.

Further, a change is made to the second lighting rate (may be the anode current of the anode terminal) or lighting rate range (may be the anode current range of the anode terminal) as the second FRC, lighting rate, current passing through the anode (cathode) terminal, reference current, duty ratio or panel temperature or combinations thereof. Or, a change is made according to (adapting to) the lighting rate (may be the anode current of the anode terminal) or lighting rate range (may be the anode current range of the anode terminal) as the FRC, lighting rate, current passing through the anode (cathode) terminal, reference current, duty ratio or panel temperature or combinations thereof.

When it is changed, it is changed with a hysteresis, with a delay or slowly. It is possible to mutually combine the technical ideas irrespective of whether regarding a part or all thereof.

The description of the driver circuit (IC) of the present invention is applicable to the gate driver circuit (IC) 12 and the source driver circuit (IC) 14, and is also applicable not only to an organic (inorganic) EL display panel (display apparatus) but also to a liquid crystal display panel (display apparatus). It is possible to mutually combine the technical ideas irrespective of whether regarding a part or all thereof.

In the case of implementing the FRC on the display apparatus of the present invention, the red video data (RDATA), green video data (GDATA) and blue video data (BDATA) are stored in a frame (field) memory 5041 as required as shown in FIG. 504. Each of the video data is 6 bits. The video data stored in the frame (field) memory 5041 is read, inputted to a gamma circuit 764 and gamma-converted to become 10-bit data. The video data rendered as 10 bits is rendered as 8 bits in an FRC circuit 765, and is applied to the source driver circuit (IC) 14 in 4FRC.

Thus, the video data is stored as 6 bits in the memory 5041 to reduce the memory size, converted to 10 bits in the gamma circuit 764 and converted to 8 bits by FRC processing so as to input it to the source driver circuit (IC) 14. This configuration is desirable because the circuit configuration is easy and a circuit scale can be reduced. The above embodiments are optimal to the configuration having the memory 5041 for one screen or a part of the screen as in the case of a portable telephone.

The pixel configuration was described centering on FIG. 1 as to the display apparatus (display panel), inspection apparatus, driving method and display method of the present invention. However, the present invention is not limited thereto. For instance, it goes without saying that the methods of FIGS. 2, 6 to 13, 28, 31, 33 to 36, 158, 193 to 194, 574, 576, 578, to 581, 595, 598, 602 to 604, 607(a), 607(b) and 607(c) can be applicable.

The embodiments of the present invention (the configurations, operation, driving method, control method, inspection method, formation or placement, display panel and display apparatus using it) were mainly described by exemplifying the pixel configuration of FIG. 1. However, the matters described such as the pixel configuration of FIG. 1 can not be restricted to FIG. 1. For instance, it goes without saying that the pixel configurations of FIGS. 6, 7, 8, 9, 10, 11, 12, 13, 28, 31, 36, 193, 194, 215, 314, 607(a), 607(b), and 607(c) can also be applicable.

Further, it is not limited only to the pixel configurations, but also applicable to the holding circuit 2280 described in FIG. 231, etc. It is because the configuration is the same or similar and the technical idea is the same. It is possible to mutually combine the technical ideas irrespective of whether regarding a part or all thereof.

The pixel configuration, display panel (display apparatus), control method or technical idea of the present invention explained or described in the following Figures can be mutually combined: FIGS. 1 to 14, 22, 31, 32, 33, 34, 35, 36, 39, 83, 85, 119, 120, 121, 126, 154 to 158, 180, 181, 187, 190, 191, 192, 193, 194, 195, 208, 248, 249, 250, 251, 258, 260 to 265, 270, 319, 320, 324, 325, 326, 327, 373, 374, 391 to 404, 409 to 413, 415 to 422, 423 to 426, 444 to 454, 467, 519 to 524, 539 to 549, 559 to 564, 574 to 588, 595 to 601, 602 to 606, and so on. It is possible to implement the configuration, formation or combination mutually applied or combined. It is possible to mutually combine the technical ideas irrespective of whether regarding a part or all thereof.

The driving method, control method, or technical idea of the display panel or display apparatus of the present invention explained or described in the following Figures can be mutually combined: FIGS. 18, 19, 20, 21, 23, 24, 25, 26, 27, 28, 37, 38, 40, 41, 42, 54, 89 to 118, 122 to 125, 128, 129, 130, 132, 133, 134, 149 to 153, 177, 178, 179, .211 to 222, 227, 252, 253, 257, 259, 266 to 269, 280, 281, 282, 289, 290, 291, 307, 313, 314, 315, 316, 317, 318, 321, 322, 333, 328, 329, 330, 331, 332 to 337, 355 to 371, 375, 376, 380, 382 to 385, 389, 390, 391 to 404, 409 to 413, 415 to 422, 432 to 435, 442, 443, 455 to 466, 468, 469, 477 to 484, 504, 505 to 510, 515 to 518, 532 to 538, 565 to 573, 605 to 607 and so on. It is possible to implement the configuration, formation or combination mutually applied or combined. It is possible to mutually combine the technical ideas irrespective of whether regarding a part or all thereof.

The source driver circuit (IC) or driver circuit, the method of adjustment or control thereof (including the gate driver circuit)or technical idea of the present invention described or explained in such Figures can be mutually combined: FIGS. 15, 16, 17, 29, 30, 43 to 53, 55, 56, 57, 58, 59, 60, 61, 62, 63 to 82, 84, 86, 87, 88, 127, 131, 135 to 148, 159 to 176, 182 to 185, 186, 188, 196, 197, 198, 199, 200, 201, 209, 210, 228 to 245, 246, 247, 283 to 288, 292 to 305, 308 to 313, 338 to 354, 372, 375, 377 to 379, 381, 386, 387 to 388, 391 to 402, 405 to 408, 414, 427 to 431, 470 to 473, 471 to 480, 487, 491 to 503, 511 to 515, 525 to 527, 528 to 531, 547 to 558, 589 to 590 and so on. It is possible to mutually combine the technical ideas irrespective of whether regarding a part or all thereof.

The technical idea of the inspection apparatus, inspection method or adjustment method, manufacturing method, manufacturing apparatus or the like, of the present invention described or explained in the following Figures can be mutually combined: FIGS. 202 to 207, 223 to 226, 306, 436 to 441, 485 to 486, 488 to 490, 591 to 594, and so on. Further, they maybe mutually applied, configured or formed to or for the display panel (display apparatus), source driver circuit (IC), driving method and the like. Such technical ideas or the like can be mutually combined irrespective of whether regarding a part or all of thereof.

It is possible, irrespective of whether regarding a part or all of the following, to mutually combine the pixel configuration, display panel (display apparatus), control method or technical idea thereof, the driving method, control method or technical idea of the display panel or display apparatus, the driving circuits or controller IC (circuit) such as the source driver circuit (IC) and gate driver IC (circuit), or control circuits thereof and the method of adjustment or control thereof (including the gate driver circuit) or technical idea thereof described above. It goes without saying that they may be mutually applied, configured or formed. It goes without saying that the technical idea of the inspection apparatus, inspection method or adjustment method of the present invention is applicable to the display panel, display apparatus, or the like of the present invention. It is possible to mutually combine the technical ideas irrespective of whether regarding a part or all thereof.

It also goes without saying that the display panel of the present invention may also mean the display apparatus. There are also the cases where the display apparatus means the one having another component such as a shooting lens. To be more specific, the display panel or the display apparatus is the apparatus having some kind of display means.

It is possible to apply the technical ideas described in the embodiments of the present invention such as the display apparatus, driving method, control method or system to a video camera, a projector, a 3D television, a projection TV, an FED and an SED(the display developed by Cannon and Toshiba).

It can also be applied to viewfinders, main/sub monitors of cell phones, PHS, personal digital assistants and their monitors, digital cameras, satellite television, satellite mobile television and their monitors.

Also, the technical idea is applicable to electrophotographic systems, head-mounted displays, direct viewmonitors, notebook personal computers, video cameras, electronic still cameras.

Also, it is applicable to ATM monitors, public phones, videophones, personal computers, and wristwatches and its displays. It is possible to mutually combine the technical ideas irrespective of whether regarding a part or all thereof.

Furthermore, it goes without saying that the technical idea can be applied to display monitors of household appliances, pocket game machines and their monitors, backlights for display panels, or illuminating devices for home or commercial use. Preferably, illuminating devices are configured such that color temperature can be varied. Color temperature can be changed by forming RGB pixels in stripes or in dot matrix and adjusting currents passed through them.

Also, the technical idea can be applied to display apparatus for advertisements or posters, RGB traffic lights, alarm lights, etc. Also, it is possible to mutually combine the technical ideas irrespective of whether regarding a part or all thereof.

Also, self-luminous devices, display apparatus, or organic EL display panels of the present invention are useful as light sources for scanners. An image is read with light directed to an object using an RGB dot matrix as a light source. Needless to say, the light may be monochromatic. Besides, the matrix is not limited to an active matrix and may be a simple matrix. The use of adjustable color temperature will improve imaging accuracy. Also, it is possible to mutually combine the technical ideas irrespective of whether regarding a part or all thereof.

Also, according to the present invention, organic EL display panels are useful as backlights of liquid crystal display panels. Color temperature can be changed and brightness can be adjusted easily by forming RGB pixels of an EL display panel (backlight) in stripes or in dot matrix and adjusting currents passed through them. Besides, the organic EL display panel, which provides a surface light source, makes it easy to generate Gaussian distribution that makes the center of the screen brighter and perimeter of the screen darker.

Also, organic EL display panels are useful as backlights of field-sequential liquid crystal display panels which scan with R, G, and B lights in turns. It goes without saying, as a matter of course, that the technical ideas of the present invention may be used as a white or monochromatic backlight or front light without forming the pixel 16. It is possible to mutually combine the technical ideas irrespective of whether regarding a part or all thereof.

It is also possible to use the technical ideas of the present invention not only for an active matrix display panel but also for a simple matrix display panel. Also, they can be used as backlights of liquid crystal display panels for movie display by inserting black even if the backlights are turned on and off. It is also possible, by means of the apparatus or method of the present invention, to implement white light emission and use it as the backlight of a liquid crystal display. It is possible to mutually combine the technical ideas irrespective of whether regarding a part or all thereof.

The present invention is not limited to the above embodiments. Various deformations and changes are feasible in its implementation stage to the extent of not deviating from the gist thereof. It is also possible to implement the embodiments in combination as much as possible, and the effects of the combination can be obtained in such cases.

The program of the present invention is the one for having the functions of all or a part of the means (or devices or elements) of the above-mentioned EL display apparatus of the present invention executed by a computer. It is the program for operating in cooperation with the computer.

The program of the present invention is the one for having the operations of all or a part of the steps (or processes, operations or actions) of the driving method of the above-mentioned EL display apparatus of the present invention executed by the computer. It is the program for operating in cooperation with the computer.

A recording medium of the present invention is the one supporting the program for having all or a part of the functions of all or a part of the means (or devices or elements) of the above-mentioned EL display apparatus of the present invention executed by the computer. It is the recording medium readable by the computer, wherein the read program performs the functions in cooperation with the computer.

The recording medium of the present invention is the one supporting the program for having all or a part of the operations of all or a part of the steps (or processes, operations or actions) of the driving method of the above-mentioned EL display apparatus of the present invention executed by the computer. It is the recording medium readable by the computer, wherein the read program performs the operations in cooperation with the computer.

The above “a part of the means (or devices or elements)” of the present invention means one or some of the means of the multiple means, and the above “a part of the steps (or processes, operations or actions)” of the present invention means one or some of the steps of the multiple steps.

The above “functions of the means (or devices or elements)” of the present invention means all or a part of the functions of the multiple means, and the above “operations of the steps (or processes, operations or actions)” of the present invention means all or a part of the operations of the multiple steps.

A form of use of the program of the present invention may be the form recorded on the recording medium readable by the computer and operating in cooperation with the computer.

A form of use of the program of the present invention may be the form transmitted in a transmission medium, read by the computer and operating in cooperation with the computer.

A ROM is included as the recording media, and the transmission medium such as the Internet, and light, radio waves and sound waves are included as the transmission media.

The above-mentioned computer of the present invention is not limited to sheer hardware such as a CPU but may also include firmware, an OS and peripherals in addition.

As described above, the configurations of the present invention may be implemented either software-wise or hardware-wise.

### INDUSTRIAL APPLICABILITY

The present invention is useful in that a better image display can be obtained by using the organic EL display panel for instance.

What is claimed is:

1. An EL display apparatus comprising:
EL elements and drive elements placed like a matrix;
a voltage gradation circuit for generating a program voltage signal;
current circuit means of generating a program current signal; and
a drive circuit means of applying a signal to the drive elements, having a switching circuit for switching between the program voltage signal and the program current signal.

2. A driving method of an EL display apparatus having EL elements and drive elements placed like a matrix formed therein and having a source signal line for stamping a signal to the drive elements, in which:
one horizontal scanning period has a period A for applying a voltage signal to the source signal line and a period B for applying a current signal to the source signal line; and
the period B is started after an end of, or concurrently with the period A.

3. An EL display apparatus comprising:
a first source driver circuit connected to one end of a source signal line; and
a second source driver circuit connected to the other end of the source signal line,
in which the first source driver circuit and the second source driver circuit output currents corresponding to gradations.

4. A driving method of an EL display apparatus having pixels formed like a matrix, in which:
a lighting rate is acquired from a size of a video signal applied to the EL display apparatus so as to control a flowing current correspondingly to the lighting rate.

5. An EL display apparatus comprising:
a first reference current source for prescribing a size of a first output current to be applied to red pixels;
a second reference current source for prescribing a size of a second output current to be applied to green pixels;
a third reference current source for prescribing a size of a third output current to be applied to blue pixels; and
control means of controlling the first reference current source, the second reference current source and the third reference current source,
in which the control means changes the sizes of the first output current, the second output current and the third output current in proportion.
